(19) United States
(12) Patent Application Publication
(10) Pub. No.: US 2026/0127945 A1
(43) Pub. Date: May 7, 2026

(54) METHODS, SYSTEMS, AND APPARATUSES FOR PROCESSING SPORTS-RELATED DATA

(71) Applicant: AdrenalineIP, Washington, DC (US)

(72) Inventors: Casey Alexander HUKE, Washington, DC (US); Joseph W. BEYERS, Saratoga, CA (US); John CRONIN, Jericho, VT (US); Michael D'ANDREA, Burlington, VT (US); Harrison GRANT, Simi Valley, CA (US); Joseph BODKIN, Quincy, MA (US)

(73) Assignee: AdrenalineIP, Washington, DC (US)

(21) Appl. No.: 18/701,294

(22) PCT Filed: Oct. 14, 2022
(86) PCT No.: PCT/US2022/046719

§ 371 Date: Apr. 15, 2024

Related U.S. Application Data
(60) Provisional application No. 63/256,103, filed on Oct. 15, 2021.

(51) Int. Cl. G07F 17/32

(52) U.S. Cl. CPC G07F 17/3288

(57) ABSTRACT

A method, system, and apparatus for collecting, manipulating, transmitting, and interpreting data. In one embodiment, a plurality of sensors configured to capture real-time sensor data from a live event including a plurality of actions; one or more sport gaming platforms, and a user device, where the one or more sports gaming platforms are configured to: receive and store the captured sensor data, filter a historical sensor database on similar event data matching an ID for an upcoming action, wherein the ID identifies odds on upcoming plays, determine, based on artificial intelligence and/or machine learning and before occurrence of the upcoming action, that there is a high correlation between the captured sensor data and the similar event data, determine a probability of occurrence of the upcoming play associated with the wager ID, and update odds offered by the exchange system.

### CROSS-REFERENCE TO RELATED APPLICATIONS

The present patent application claims benefit and priority to U.S. Provisional Patent Application No. 63/256,103 filed on Oct. 15, 2021, which is hereby incorporated by reference into the present disclosure.

### FIELD

The embodiments are generally related to wagers in sports or athletics that are focused on player's sensor data.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Currently sport betting platforms offer proposition bets or proposition wagers for individuals and teams competing in an event. These “prop bets” are focused on the player's or team's statistics that are gathered and collected over the course of the event. However, these proposition bets are limited to the statistics within the sport or event and have little to do with some of the athletic feats that the athletes perform over the course of an event. Sports fan usually debate the athlete's skill and performance so there is strong interest in the athlete as well as the final game outcomes.

This invention deals with capturing play data and communicating it to the user's mobile device for play-by-play betting can be problematic when the user is at the live game. The large number of people in the stadium makes reliable bandwidth problematic and that could cost wagering providers potential revenue with missed opportunities to bet.

A bettor may restrict their betting to a particular type of bet or another criterion such as odds meeting their own personal threshold. Behaviors such as this restrict the potential number of bets which may be made. Some bettors may be more likely to take a particular type of bet regardless of the odds. In this case, offering the bettor the same odds as someone less likely to make the bet would be contrary to the interests of the bookmaker, as they would likely make the bet even with poorer odds.

Environmental factors such as home team advantage, and the likelihood of a bettor favoring the home team. As such, the bettor may be more likely to favor bets pertaining to the home team. Similar to favoring a particular kind of bet, the favoring of one team versus another may result in the bettor making fewer bets.

A bookmaker collects a fee on every bet placed, therefore it is beneficial to the bookmaker to increase the number of bets made. By incentivizing bets which would otherwise not be made by increasing the odds in favor of the bettor, the bookmaker can increase the overall number of bets made. Similarly, there is a benefit to reducing the payout wherever possible, therefore it is beneficial to identify bets which have a high likelihood of receiving a bet by a bettor, even a lower odd that would otherwise be offered, and decreasing the odds for the bet before offering the bet to the bettor.

Traditional advertisements required maximum exposure to see an adequate return on investment. With the advent of digital marketing, it has become possible to target individuals instead of groups of people, however the amount of personalized information required to achieve this is difficult to obtain, as is determining the timing during which to deliver advertisements.

Live events often rely on passive advertisements, traditionally via advertisements which are placed on uniforms, on billboards within stadiums and even in the naming of stadiums themselves. These advertisements are largely inefficient as they are only relevant to a segment of the individuals present and while they can be changed during a live event, the still suffer the same inability to be relevant to each individual present.

Live events often involve spectators who are emotionally involved with the event itself, such as when the live event is a sporting event. Typically, spectators are emotionally invested in one of the teams and therefore may be more likely to be influenced by an advertisement depending on how events unfold, however these experiences vary widely depending on the person, requiring a personalized means of delivery for advertisements to be most effective. Advertisements have an improved return on investment if they are targeted towards the individuals most likely to be influenced by them. This can be further improved by also delivered to an individual the most appropriate time.

Currently sport betting platforms provide users with wagering odds which are usually calculated using some sort of statistical analysis on the two teams of event. A current issue with this analysis is that it does not incorporate data on a player by player basis and is determined by looking at the team as whole. While this is acceptable for wagers on the event, this may cause issues when determining odds for wagers on a play by play basis and player data, especially data collected from sensors on the player, on the field, or at the event in general, can be incorporated in order to improve the wagering odds.

Micro event betting has become more popular and is largely being facilitated by the efficiency of smart phones. One problem is how to advertise directly to the micro bettor market.

Another problem is that since micro events take place during a macro event, there are options available to micro event betting that would not be useful to macro event betting and are not being utilized by the current market.

Advertisers who want to reach micro event bettors or move merchandise need a system in place to identify targeted users and bets before the macro event because micro event betting is face-paced and real-time.

Experienced bettors will more often be able to win their bets because they are more knowledgeable about the specific game or event they are betting on. This means that if the odds are completely fair based on random chance, experienced bettors can end up costing the bet offeror money.

The obvious solution would be to lower the bet odds so that the bet offeror doesn't lose any money, but this means that low experience and new bettors suffer from artificially lowered odds because of the experienced bettors. This can drive away new clientele and could be considered unfair to casual bettors.

Traditionally it has been very difficult to target bettors as individuals because the bet offeror would have to show everyone the same odds.

A current issue within sports gambling is that throughout the course of an event player's need to perform at peak physical condition but as the game moves along the player's may not be able to perform as they would in the beginning of the event, but this is not taken into consideration when creating odds for a wager. Professional athletes get tired, play through injuries, etc. which affects the outcomes of events, but wager odds do not take this into consideration, although the player's physical state directly results their performance on the field of play.

It is customary for people to wager on games and other sporting events. However, due to the complexity in placing wagers, it is often difficult for users to place wagers on certain aspects of the game outside of its outcome or score. Another problem is that programs that would allow users to place wagers on game events are currently unable to accurately calculate the odds of the next game event. Yet another problem is that inaccurate odds lead to inherent unfairness in wagering which has a negative effect on user retention.

Play by play wagering happens very rapidly and there are often multiple events occurring simultaneously, such as Sunday afternoons during American football season, when as many as a dozen games are occurring simultaneously. With a forty second play clock, there is very little time to determine which wager or wagers a user is interested in, understand the odds and make a decision based on the available information. Currently in the art there is no solution to allow users to be notified of potential wagers that they may be interested in. Also, in the art there is no solution for users to be able to filter currently available wagers that are similar to wagers the user has previously wagered on.

When odds are calculated for a wager objective data and statistics are used so that the payout is proportional to the actual chances of the outcome. A problem is that people do not usually place wagers based on objective data, which can result in largely one sided bets that could result in a loss for the house. Another problem is that when demand one side of a wager greatly exceeds the demand expected based on the odds, the house misses out on profit it could have made by offering lower odds. Yet another problem is that errors in the original odds calculation could be exploited by clever users if the odds aren't subsequently adjusted.

While sports gambling is popular, it is often rather impersonal and isolating for users, as the gambling software is typically between the user and a computer system that is offering the wagers.

The sports wagering market today provides for numerous new opportunities with wagering with individuals in regards to specific events inside of a real time sporting event. The fast paced nature of this new type of in-play wagering is uniquely suited to a more social style of wagering than offered by traditional sports books and or online wagering platforms.

Parlays and other special games that allow a user to combine wagers on multiple events in order to manipulate the odds and payout are common in most forms of sports gambling.

Play by play wagering systems in sports gaming are in early stages of development and do not offer parlay type of wagering opportunities.

Current broadcasts of live sporting events frequently display additional information to viewers, such as statistics about the game, scores of other games, advertisements, etc. integrated into the display of the live event, often in the form of a ribbon on the bottom or side of the screen or overlaid onto the playing surface. Viewers have no manner with which to change what information is displayed where and when. Often scores and statistics flow across a ribbon like a stock ticker, and viewers need to wait for the information to cycle back around.

Second screen experiences have become a big part of television viewing, often with viewers spending more time engaged with their mobile device than the television.

Third parties, such as fantasy sports platforms, statistics services, news outlets, and sportsbooks are creating more and more content for that second screen experience.

Current sports betting platforms provide numerous different ways to wager on entire sporting events, or individual aspects or portions of those events. However, they do not provide a manner of wagering on the movements of players or objects in the field of play.

Augmented reality and virtual reality devices, and the content for them, continue to improve. Their use with live sporting events is evolving, but largely remains a novelty and lacks a manner of keeping the user engaged with the event in a manner that is novel to the new interface type.

When wagering on a sporting event or portion of a sporting event, having the actual result relative to the user's wager is desirable. If the wager is based on the path of player or object in the field of play, there is no current product that will compare the projected path to the wagered upon path.

With the U.S. Supreme Court invalidating the 1992 Professional and Amateur Sports Protection Act, legalizing sports gambling, there will be a proliferations of online platforms that allow users to wager on sports through their mobile devices.

As mobile apps make wagering on sports easier and in-play betting makes wagering faster platforms and users need tools to ensure responsible gaming, such as wager amount or frequency limitations.

Wagering platforms need tools to ensure wagers or users are compliant with the rules of betting to prevent cheating.

While sporting events with many stoppages in play make it easier to have many wagering opportunities in a single game, more fluid sports like soccer or basketball, need wagers that can be adapted to that sport.

Current sports betting platforms provide numerous different ways to wager on entire sporting events, or individual aspects or portions of those events. The number of these options continues to increase making it difficult for a user to know how best wager on sports. Being overwhelmed with options can lead to users making poor bets and becoming discouraged with the process.

Data analytics, including both statistics and calculated or processed analytics data, has become a mainstay in professional sports, not just with teams evaluating and training their players, but with broadcasters and content creators communicating the nuances of sports to their users. With so much data available, it is hard for fans to know what data to look at when.

When wagering on a sporting event or portion of a sporting event, it is important to have the information a user relies upon to make their decisions readily available. There is simply too much information to be able to fit all the relevant data on the screen with the sporting event.

With the U.S. Supreme Court invalidating the 1992 Professional and Amateur Sports Protection Act, legalizing sports gambling, there will be a proliferation of online platforms that allow users to wager on sports through their mobile devices. Users are faced with the choice of only using one platform for all their wagers, reducing their betting options, or giving their banking and/or credit details to multiple wagering platforms, potentially compromising their security.

Sports fandom has shifted recently with fans being more attached to a particular player than any one team, making it more difficult to deliver content that will maintain their engagement.

Current sports betting platforms lack a way of driving user engagement and do not offer a way to encourage users to continue to place wagers through a live event.

A wagering platform can provide notifications of live events upon which an individual may place a wager, however it can be difficult to motivate a user to place wager, even if they are registered. However, a user who is either not watching a live event or may be watching but not placing wagers may not be sufficiently aware or engaged to make wagers.

Individuals wagering on a live sporting event will typically have a preference for a type of wager that they will accept, such as on whether a team in an American football game will run or throw, instead of wagering on whether the team will score on the next play. However, there is no current way to encourage these individuals to place wagers more frequently or place wagers on plays that they otherwise might not otherwise consider.

There are numerous ways to calculate odds on the potential outcomes of a single play in a sporting event. Determining the proper odd making formula to use in a given context is an important choice for a sportsbook to make. Formulas could be, for example, formulas that are in and of themselves computer program modules designed to find profitable sports betting opportunities. These programs use vast amounts of data from past sporting matches so as to identify patterns, which can then be used to calculate the probability of certain sporting outcomes. In most cases, primary betting algorithms calculate the probability of various outcomes, and compare those probabilities to the odds offered by bookmakers, so as to identify bets that are worth placing.

Betting lines are not designed to reflect the real and accurate probability of either outcome. Users attempt to gain an edge over sportsbooks by making a wager when they think there is a discrepancy between the real probability of an event and the implied probability determined from a betting line. Contemporary odds making is just as much a risk management proposition as it is a method of predicting the outcome of sporting events.

Wagers placed on a live sporting event with two outcomes will yield wagers on each side of the outcome. While the odds are typically set to weigh the less favorable outcome with a greater potential payout to balance the risk to the bookmaker, bettors may still prefer to place their wagers on the more favorable outcome in numbers great enough to expose the bookmaker to unacceptable risk.

The risk exposure of a bookmaker is typically reduced by an increase in the number of wagers, however an imbalance in the distribution of wagers can also create risk regardless of the number of wagers placed. If too many wagers are placed on an outcome with more favorable odds, it becomes necessary to incentivize wagers on the less favorable outcome, usually by adjusting the odds such that a greater potential payout would encourage bettors to place wagers.

A bookmaker may change the odds of a less favorable outcome to incentivize bettors to place wagers on the less favorable outcome, these odds largely appeal to and benefit bettors who have not already placed a wager. This method relies largely upon new bettors placing wagers on the less favorable outcome in response to the greater potential payout. Current methods do not offer a means of appealing to bettors who have already placed a wager as they are already engaged and actively placing wagers.

Play by play wagering platform operators typically profit either via a fee per wager or by taking a percentage of all wagers made. In the case of a percentage cut, it is in the interest of the operators to encourage users to place the maximum wager they are willing to place.

When placing wagers on a play by play wagering platform, it can be difficult to change a wager once placed before the betting period closes. The short wagering window is due to the rapid pace of most sporting events, usually leaving at most a couple minutes to place a bet and reconsider. As such, a method of quickly adjusting a wager prior to the close of a betting period is needed.

Some sporting events have less time to place a wager than others when placing wagers on a play by play wagering platform. For example, a baseball game may allow a couple minutes or longer if there is a pitcher or side change, however in an American football game, the play clock allows only 40 seconds. Furthermore, teams are not required to use the entirety of the time on the play clock resulting in time between plays less than the allowed 40 seconds. For this reason, allowing a user to quickly place a wager may increase the quantity and amount of wagers placed.

Play by play wagering platforms are challenged by the short duration during which users may place wagers on a play. It is not uncommon for a user to have less than a minute to decide what to wager between plays.

The operator of a play by play wagering platform's profits are largely dependent on the volume of wagers placed during a live event. As such, maximizing a user's engagement and wagering activity is desirable. It is therefore advantageous to prevent the user from missing out on wagering opportunities upon which they would normally place a wager.

During a live event, a user may become engrossed in the gameplay and therefore be less attentive to the wagering opportunities which may be available to them.

Fantasy sports have become a multibillion-dollar industry that has provided an indirect way for users to wager on sports. With the path to broader access to legal sports gambling, fantasy sports platforms will be seeking ways to integrate those options in order to retain their customer base.

Users who wager on sports are likely to be a user who would engage in other forms of gaming.

With such a wide variety of casino games, it is difficult for a provider to know which casino games are likely to engage a given user.

The prevalence of social media has made the capturing of significant or exciting events important to many people. The spread of sports wagering that has accompanied the Supreme Court's ruling on the Professional and Amateur Sports Protection Act is going to create a number of opportunities for exciting wagering experiences. To capture these experiences users currently need to capture the experience in real time, taking time and focus away from both their wagering experience and their experience of the live sporting event they are wagering on. The user may want to capture information from the live event, the wagering platform and their own experience, in order to memorialize the experience. To capture all this data efficiently would require significant resources from the user.

Current sports betting platforms provide numerous different ways to wager on entire sporting events, or individual aspects or portions of those events. Betting on portions of events, or micro-betting, has become more accessible due to advancements in technology. However, as with the emergence of any new market that branches off from an existing market, micro-betting comes with new opportunities and problems that betting on an entire sporting event did not have. One problem is that it may be difficult to communicate with others which portion of an event a person successfully wagered on. Especially when there are multiple portions of the event that can be described the same way, for example in football a conversion on 3rd and 10 during the first quarter may describe more than one play. Further, a bettor may have a net gain over the course of an event but may not remember exactly what they wagered on each individual portion of the event that lead to that net gain.

One problem that arises with placing bets during a live event is that odds calculation must be done in real time. This often leads to issues wherein certain risks to the wager offeror are not accounted for.

Current sports betting platforms provide numerous different ways to wager on entire sporting events, or individual aspects or portions of those events. One problem that arises with placing bets during a live event is that odds calculation must be done in real time. This often leads to issues wherein certain risks to the wager offeror are not accounted for.

These risks may arise from a lack of data to calculate odds accurately or a widely varying set of odds for similar scenarios. Further odds calculation based on historically measurable criteria such as weather data, player data, game data, etc. does not account for the immediate losses that the wager offeror may be suffering currently, but not historically.

While high frequency and high wager amount bettors represent a significant portion of a wagering network's profits, it rarely represents the majority. Despite this, it is generally easier to increase the engagement of established users than to draw new users to a wagering network. Similarly, it is easier and there is a higher likelihood of success in increasing the engagement of high frequency and high wager amount bettors than their less frequent or lower amount counterparts.

High frequency low wager amount bettors can be very profitable for wagering networks which collect a flat fee for each wager, however some wagering networks collect a percentage of the amount wagered. For these wagering networks, encouraging their users to increase their wager amount could result in a substantial increase in profits.

Low frequency high wager amount bettors can be very profitable for wagering networks which collect a percentage of the amount wagered, however increasing the frequency of wagers will result in a substantial increase in the profitability of the wagering network.

When a wager with fixed odds is offered to a large enough number of people, the offeror of the wager is becoming insulated from risk when the losses from one outcome are offset by the winnings of another outcome. By adjusting the odds such that the offeror of the bet comes out slightly ahead regardless of outcome, over time the offeror of wagers becomes profitable. However, if a disproportionate amount of people place wagers on one outcome over the other options, the offeror of the wager will be at risk if that outcome occurs.

To remedy this issue, offerors of wagers often have to adjust odds in order to incentivize people to bet on the less popular wager options, cap the number of people who can select a wager option, change from a fixed odds system to a para-mutuel or betting pool system, or disincentivize users from continuing to bet on the popular option by reducing the payout. All of these options have their own drawbacks which offerors of wagers may seek to avoid.

Offerors of fixed odd wagers set the odds they offer to a value that will statistically yield a profit despite the outcome of the event being wagered on. However, because of the slight advantage of the wager offeror, over time long-term players will begin to notice a pattern of loss. Further, if odds are set too low, short term profits may increase but less bets may be placed over time if there is a diminished incentive to bet.

To remedy this issue, offerors of wagers often adjust odds to payout better in order to incentivize current or past players or to draw in new players. However, this ultimately will result in some amount of loss to the offeror of the wagers. Any entity that offers wagers must then balance the odds such that the entity is still profitable but also retains as many current players and draws in as many new players as possible.

With broader access to sports wagering becoming possible after the U.S. Supreme Court struck down the Professional and Amateur Sports Protection Act in 2018 wagering on mobile devices will become a significant portion of this new market.

As more wagering options become available on live sporting events more providers will move to fill those options. With more providers and more wager options it is likely that no one provider will offer all available wager options.

An increase in the number of wagering providers increases the importance of being able to compare odds offered on the same wager option.

Current sports betting platforms provide numerous different ways to wager on entire sporting events, or individual aspects or portions of those events. One problem that arises with placing bets during a live event is that the placing of the bet and the subject of the bet (i.e. the next play of the game) are very close to each other in time. This means the window for placing a bet may only be open for a matter of minutes or seconds.

As the betting window must close before the portion of the event is complete, users need to be made aware of how little time they have left so that they are not cut off from making a wager. If, for example, a user is in the middle of placing a bet and the next play of the game begins, the user will lose the ability to finish making that bet. This may lead to user's becoming frustrated.

A wagering network is intended to provide users the opportunity to place wagers during a live event, however the use of automation may provide the user an unacceptable advantage. Unfortunately, detecting the use of automation can be difficult and the operator of a wagering network may suffer losses as a result.

Cybersecurity is a constant consideration and challenge for anyone operating a software service. Accounts can be highjacked by autonomous bots and used to earn illicit gains or cause harm to users or the operators of a service. This could cause considerable harm to the reputation of a wagering network operator and result in considerable losses.

Fake accounts created and managed by bots could place high frequency wagers based on data models to optimize winnings. This could disadvantage the operator of a wagering network resulting in significant losses. While the use of such bots might be violations of a wagering network's terms of service, identifying the activity of these bots and intervening can be difficult.

With broader access to sports wagering becoming possible after the U.S. Supreme Court struck down the Professional and Amateur Sports Protection Act in 2018 wagering on mobile devices will become a significant portion of this new market.

As more wagering options become available on live sporting events there is a need to determine what subset of available wagers will be displayed to the user in the limited amount of screen space on mobile devices. This becomes more important if the wagers are being displayed along with the sporting event on the same display.

Wagering on individual plays of a live sporting event, or micro-betting, is a type of wagering that has a very short time window in which a bettor may place a wager.

This short time window may be problematic for people who prefer to research prior to placing a wager due to the limited timeframe in which one may gather relevant information.

The time spent closing an application and opening another can be critical, especially when the betting window is on the order of minutes or even seconds. Users need a way to quickly obtain relevant information without having to exit the application used to place a wager.

Currently, an issue on wagering applications and wagering platforms is that a user is not informed of any statistical data based on their wagering history before confirming a wager.

Also, another issue on wagering applications and wagering platforms is that a user is not informed of any statistical data based on a similar user's wagering history before confirming a wager.

Lastly, the user's wagering history is not easily displayed on wagering applications. For example, while the user is in the process of placing a wager, the user is forced to look at their wagering history separately in a wagering application.

Thus, there is a need in the prior art to display and inform a user of their wagering history while still allowing the user to place wagers on the same interface or display screen.

Currently, it is difficult on wagering platforms and applications to track the user's interactions with time stamping user actions to determine user behaviors.

Also, another issue on wagering platforms is providing the users with incentives and rewards to continue to use the wagering platform to place wagers based on their behaviors interacting with the platform.

Lastly, it is difficult on wagering platforms to group users into cohorts depending on their behaviors on the wagering platform besides using their profit and loss margins.

Accurate odds calculation is critical to any business model that offers wagers. Inaccuracy in calculating odds may lead to huge losses at one extreme and customer dissatisfaction at the other.

Odds for an individual play may be calculated based on finding similar plays and the outcome of those similar plays. However, this method may be problematic because it looks at all plays in a snapshot in time and not in the context of the entire game.

Strategy can often be more influential on the outcome of a play than factors such as the players themselves or their environment. Coaches or players themselves, may implement a certain strategy for a play based on setting up a big payoff for one or more plays in the future.

Currently, an issue with wagering platforms is keeping users engaged after they have lost a wager. that users are less engaged than they lose as there is no way to recoup their losses besides wagering more money which can lead to the users stopping playing on a wagering app.

Users become more selective with their wagers the more they lose.

Also, there is currently no way for users of a wagering app to recoup losses besides wagering more, which may lead to increased losses and possible discontinued use of the wagering app altogether.

Wagering on the outcome of plays of a live sporting event, or micro-betting, is a growing market facilitated by advancing odds calculation speeds. Traditional betting on sporting events is usually done far in advance and based on entire outcomes such as which team wins, the point spread, which team is ahead at half-time, etc.

Between these two extremes is a form of betting based on more than one play but still requires fast odds calculation with real-time data. One of these types of multi-play wagers is “per-drive” wagering or wagering on the number of plays before an event occurs. “Per-drive” refers to American football games where a drive is a series of plays when the offense has the football until it punts or scores and the other team gets possession of the ball.

The main issue with this type of wagering is that it changes with the state of the live sporting event and requires live data and requires odds calculations to simulate possible future plays.

Play-by-play wagering or micro-wagering has a very short time window since each play of a live event is often shorter than a few minutes.

This can lead to wagers that are placed very quickly and without careful checking by the bettor.

Thus, a problem with micro-wagering is that it is much more likely that an error in the betting amount may go unnoticed, for example, adding an extra digit to a wager amount and increasing the amount wagered by at least ten times.

Single-play betting or micro-betting is the practice of wagering on the outcome of a small event, such as a play, within a large event, such as a game of baseball. Accordingly, the amount of time bettors can place a wager is small.

Closing the betting window too late can cause the offeror of the bet to take losses because the outcome of the play is already decided or close to decided by the time wagers stop being placed. On the other hand, closing the wagering window too early can cause loss of revenue due to bettors being excluded and may also cause bettors who feel rushed to be frustrated.

One solution to these problems is to manually close the betting window when a play is about to begin or has begun. However, this solution has its own set of issues. It may increase labor costs to hire people to make these manual decisions, and it may invite human error into the system.

Sports wagering is often a group activity. Friends may gather to watch events or may virtually connect to discuss the game as they watch it live.

While these groups of friends, family, and acquaintances may be watching the same game, they may not necessarily be wagering on the game through the same company or application.

Real-time betting on single plays or micro-betting has a short betting window. The window opens around the same time as the last play of a live event ends and closes before the play being bet on starts.

One problem that arises with such a small betting window is that latency between the bettor and the offeror of the bet is a significant factor. When a wagering market is only open for a matter of seconds, even latency measured in milliseconds can affect bettor experience.

Further, latency for different types of data may cause multiple data streams to be out of sync. This latency may cause betting markets to open before the video data shows the end of the last play. This asynchronous delivery of data could cause bettors to be distracted and split their attention between the play they are currently watching and betting on the next play or spoil the result of the current play.

Calculating odds in real-time for every single play of a sporting event is a time-sensitive and processing power-intensive task. In some sports, the time between plays can be less than thirty seconds on average.

Due to the small amount of time between some plays in a sporting event, giving the algorithms that calculate odds time to work may require that odds calculation one or more plays in advance. The results of the future plays must be simulated so that odds can be calculated for possible plays.

A problem that arises when plays are simulated is that the number of possible future plays increases exponentially. Therefore, there is a need to reduce the number of possible future plays to save on time and processing power.

The time required to calculate odds by different methods varies, but often, to increase the speed at which odds are calculated, the accuracy of those odds must be reduced. Thus, there is a need to create a balance between the accuracy of odds and the speed at which those odds are calculated. Further, there is a need to substitute more accurate odds for the quickly calculated odds when they become available.

Ticker feeds are a common fixture on sporting and news television channels to relay information from many live events. Regarding sports, the ticker typically shows scores of live sporting events and those which have concluded. Tickers may also provide news updates that may include a player's injury status, whether a player has signed a new contract with another team or reached a career milestone. These tickers are not typically customized to the viewer.

Play-by-play wagers generally have a short opportunity to place a wager, and pertinent information, such as a game's current score, a player's injury status, or a player's year-to-date statistics, may be critical to the user of a wagering app in deciding whether or not they may place a wager on any given play. Therefore, timely delivery of this information is critical as it may influence a user's decision to place a wager.

Ticker feeds are typically passive features that display a list of information in sequential order. They are not intended to be interacted with, particularly given that they have traditionally been used in television. However, on a wagering app, interaction may be possible and could increase the number or amount of a user's wagers.

By customizing the order of ticker elements in a ticker feed, a user can be provided the most relevant ticker elements to their preferred types of wagers before the less relevant information. This customization may increase the likelihood that the user may place a wager on a given play. Similarly, the ability to view wagers related to a ticker element, especially which also match the user's wager preferences, can allow for the timely presentation of wagering opportunities to the user so that they miss fewer wagering opportunities.

Many sports fans like to follow multiple teams or players. These fans may watch multiple games a day.

However, many people may be undecided about watching the next game as sports games can often run for hours. Because of this, many people may only be able to watch part of a game.

People who may not have time to watch another full game or who have had lousy luck betting on the game they are already watching may decide not to watch another game at all.

Currently, wagering platforms and wagering applications, it is difficult to determine a user's long-term value to the platform or application and the user's engagement on the platform or application.

Also, it is difficult to group the important or highly valued users into certain groups or cohorts based on their value to the platform or application.

Lastly, it is challenging to determine a new user's value to the wagering application or platform and determine the user's engagement on the application or platform when there is insufficient data to support a prediction.

Wagering on the individual plays of a live sporting event, or micro-betting, requires odds to be calculated in real-time. Small changes, such as wind speed or a player substitution, which may be insignificant to traditional wagering, can be critical for micro-betting.

During the short duration of micro-markets, the odds for wagers may be recalculated and updated leading up to the actual play. Frequent recalculations based on incoming wagers can mean that odds may not remain consistent for more than a few moments.

These rapid odds changes can be problematic for bettors who want to understand these changes in odds. As odds may bounce from one number to another rapidly, it may be difficult for bettors to keep track.

Currently, on wagering platforms and wagering applications, there is no easy method to predict how a user will wager on possible wager outcomes using the user's historical data for similar wagers.

Also, there is no easy method to predict or forecast how much money will be wagered by the user by using the historical tendencies of the user from similar or comparable wagers.

Lastly, there is no way to forecast user behavior and update or alter the wagering odds before the odds being released to the public.

Thus, there is a need within the prior art to provide a method for indirect odds making by using the historical data from users from similar wagers to determine how the user will wager in an upcoming wager market.

Currently, on wagering applications and wagering platforms, users have limited options for wagering on potential outcomes of current plays.

Also, when wagering on outcomes of specific plays, users are limited because the wagers are not updated based upon the outcome of the previous play.

Lastly, there is currently no method to have a constantly updated rolling sequence from a play-by-play standpoint.

Thus, there is a need within the prior art to offer users a rolling sequence of wagers for outcomes on each continuously updated play.

While many sports fans support a team or teams, some are also instead in supporting individual players. This trend may continue to grow due to the increase in the social media presence of individual players.

Unfortunately, this may mean that sports fans that follow different players on different teams may not be able to watch all the games in which those players are playing in real-time, especially when they are on at the same time.

Fans who might love to place wagers on their favorite football player may also not want to miss out on watching their favorite basketball team or may already have agreed to watch a baseball game with friends or family.

While playing on a wagering network or wagering application, it is difficult to join contests, tournaments, or pools with other players or users of the same skillset.

Also, there is currently no way for the user to know if they are playing against an appropriate level of competition within a contest, tournament, or pool within a wagering network.

Lastly, it is difficult to break up a wagering network's users into various cohorts or groups based on skill or how often the users may play on the wagering network.

Also, there is no method to award users for making wagers less likely to happen in a pool or contest with other players.

Driving engagement within a wagering network is key to maximizing a bettor's wagering potential. Unfortunately, many users prefer to place wagers only on specific teams, players, types of wagers, etc., or combinations thereof. This can result in significant time between wagers the bettor would consider placing during which the bettor may leave the application resulting in missed wagering opportunities.

While a bettor may be interested in placing wagers on a live event, they may not be dedicated to watching the live event or may otherwise have their attention captured by another event or situation. Without intervention, this bettor likely would not place wagers on the live event. Thus, a general notification attempting to prompt engagement would be ineffective against such a bettor.

Mobile devices and notifications have become ubiquitous; however, some notifications may go unintentionally ignored. It is therefore desirable to differentiate notifications and make them increasingly more noticeable and recognizable by a bettor.

Pairing recognizable notifications with wagering opportunities matching a user's preferences allow users to leave a wagering application during a live event without missing wagering opportunities that they may be interested in placing a wager on. Similarly, this maximizes the potential wagers placed by the user of a wagering application without requiring the user to be engaged with the wagering app throughout the live event. Similarly, this may enable users to be engaged with multiple live events simultaneously or be selectively engaged with the wagering application while their attention is otherwise consumed.

Currently, users are prevented from downloading their data to their devices on wagering platforms and wagering applications.

Also, users are forced to use analytic systems provided by the wagering applications or wagering platforms to analyze their wagering habits, resulting in users performing their own accounting methods to track their wagering habits.

Lastly, there is currently no method to allow the users to extract their wagering data and allow a 3rd party system to analyze their wagering data.

Thus, there is a need in the prior art to allow the users to store their wagering data locally on their devices.

Watching and wagering on sports events are activities that many people enjoy with others. However, gathering people physically together can be inconvenient at best and dangerous at worst due to circumstances such as a pandemic.

Without gathering with friends or family, many people may not participate in sports wagering, may reduce the amount they wager, or may not watch major sporting events at all.

Online group calls or chat may be one way of dealing with these issues but communicating can quickly become hectic and does not accurately track the wagers being placed.

Micro-betting or micro-wagering has become very popular among sports fans. In order to facilitate this, gaming systems must be able to calculate the odds of the outcome of a play quickly.

A problem that arises is that in some sporting events, the window of time between the start of the play and the play's outcome is too short for some bettors who may be slow to react or may prefer to give deeper thought to their wagers.

Wagers too far in the future, or based on a combination of events, no longer meet the micro-betting market's needs and are closer to traditional sports betting instead.

Currently, an issue with play-by-play wagering networks is that a user is not notified in a timely fashion when and if one of their friends places a wager on the same game or wager market in which they are currently playing.

Also, there is no easy way for a user to determine wagers placed by their friends unless they exit a wagering market to view the friends wagering history, and in doing so, the user does not have enough time to place the same wager or opposite wager.

Lastly, it is difficult for users to play together as friends unless they communicate in some fashion to discuss the wagers they are making. In a play-by-play environment, communicating this can be extremely difficult due to the time constraints on the wagers.

Thus, there is a need in the prior art to notify users of friend wagers quickly and efficiently.

Currently, users have limited options for wagering on potential outcomes of current drives in a football event on wagering applications and wagering platforms.

Also, if users can wager on outcomes of specific plays or drive results, they are limited because the wager odds are not updated based upon the outcome of the previous plays.

Lastly, there is currently no method to have rolling drive wager odds constantly updated from a play-by-play standpoint.

Thus, there is a need within the prior art to offer users rolling drive result wager odds for outcomes on each play that is continuously updated.

Gamblers often rely on past success or failure in each type of wager to decide what wagers to make. For example, a gambler may have a large percentage of successful wagers on football games, thereby incentivizing them to wager more on football. While playing on a wagering network or wagering application that allows for play-by-play wagering on live sporting events, it is difficult to identify patterns and trends in one's success or failure in wagering on a particular play type because of the numerous types of plays in many different contexts of a game.

Also, in play-by-play wagering, a wagering market may be open for less than thirty seconds between plays. This short market window allows insufficient time to identify the context of the current wagering market and make comparisons to other historically similar situations.

Lastly, it is difficult to identify trends or patterns present in recent wagers in similar situations that indicate a deviation from historical averages or patterns.

Thus, there is a need in the prior art to quickly identify patterns in a user's wagering for play-by-play wagering.

Gamblers have often relied on their understanding of how contextual factors impact the expected outcome of a sporting event or sub-outcome of a sporting event as a way to decide what wagers to make. For example, a gambler may understand that as a pitcher gets tired, they have less control of their pitches and are more likely to walk a batter. However, it is difficult to identify all the contextual factors for a particular play as there are many types of plays in many different contexts of a game for which wagers may be placed on a play-by-play wagering network.

Lastly, it is difficult to identify combinations of factors that may influence the outcome of a sporting event or sub-outcome of a sporting event.

Currently, SGOs, or skilled game operators, do not have a method of reviewing wagering odds created by an artificial intelligence (A.I.) system.

Also, SGOs do not have the ability to have their corrections or inputted wager odds to be incorporated into an A.I. system that will allow a combination of wager odds from the A.I. and historical inputs from the SGO.

Lastly, there is no method to have the combined wagering odds be reviewable and still adjustable by the SGO.

Also, SGOs do not have the ability to have their corrections or inputted wager odds be incorporated in an AI system. An AI system may allow a combination of wager odds from the AI as well as weighted historical inputs from the SGO and may only incorporate the SGOs that are the best at adjusting the odds.

Thus, there is a need in the prior art to allow skilled game operators to manage micro-markets with artificial intelligence.

An issue with wagering platforms and wagering applications is that the data in which the wager odds are calculated is often inaccurate.

Also, there are times when the live event data used to calculate wagering odds is incorrect or erroneous leading to inappropriate wager markets or odds that do not properly relate to the upcoming play.

Lastly, suppose a wagering platform or application receives incorrect or erroneous data. This can cause the wager markets that are based on the wagering platform or application to suffer unexpected losses or profits, leading to decreased user engagement and a lack of trust with the platform or application.

Thus, there is a need in the prior art to have a method to determine the credibility of the data received and the appropriate wager markets and odds.

Unlike traditional sports wagering, micro-wagering is a quick-paced type of wagering wherein bettors can place wagers on events that happen within a few minutes or seconds.

Due to the fast-paced nature of these wagers, would-be bettors need a quick and simple way to view their wagering options and place a wager.

The tools to facilitate quick betting are available using touch screen technology but have not been utilized for the sake of micro sports wagering.

An issue with wagering applications and wagering platforms is that there is no additional benefit to the user while attending a sporting event.

Also, while attending a sporting event, the user cannot connect directly to the sensor data collected by the wagering platform and have it sent to the user's mobile device.

Lastly, the user may be aware of certain data types that they can witness at the live event, but which are not represented on the wagering platform or wagering application.

Thus, there is a need in the prior art to allow users of wagering platforms an additional benefit of additional sensor data while attending a live event.

Currently, an issue with wagering applications or wagering platforms is that it is difficult to determine the wagering odds for a play without the result of a first play or the previous play that occurred.

Also, it is difficult to determine wagering odds for a play in a one-off instance or in an isolated way.

Lastly, wagering applications or wagering platforms have no way to compare the wagering odds calculated in an isolated instance with wagering odds calculated from a series or sequence of play results.

On a wagering platform or wagering application, users cannot taunt their opponents, friends, users in their contact list, etc., unless it is through textual means.

Also, users are limited on wagering platforms and wagering applications in how they can celebrate or taunt other users when winning a wager or before a wager result becomes known.

Lastly, there are not specific sports wagering-related emojis, gifs, animations, or pictures that users can send one another through a wagering platform or wagering application. Thus, there is a need in the prior art to allow users to taunt or celebrate through various types of animations or pictures.

Many people enjoy watching and wagering on sporting events with others. However, gathering people together physically may be inconvenient and/or dangerous due to circumstances like a pandemic.

Participation in sports wagering may decrease when individuals do not gather with friends or family. Indeed, people may even reduce their wager amounts or may not watch or wager on major sporting events at all.

Also, people may be less interested in watching certain events—and in turn wagering on those events-without interested friends or family present. For example, some people may only watch American football with their father, a huge fan, or may only watch baseball with their friends. These people would likely not place wagers on these events otherwise.

Wagers on individual plays of a live event, or micro-wagering, are a form of wagering increasing in popularity. One of the problems presented by this type of wagering is the short window in which users can place a wager.

Because of the short window of time to place a wager, latency between the live event, the system offering wagers, and the users making wagers becomes relevant.

Latency issues can cause the flow of data to slow. Because of this, it becomes important to identify which data is critical to send and receive in real-time or near real-time and which data can remain static without compromising the user experience.

Wagers on individual plays of a live event, or micro-wagering, are a form of wagering increasing in popularity. One of the problems presented by this type of wagering is the short window in which users can place a wager.

Because of the short window of time to place a wager, latency between the live event, the system offering wagers, and the users making wagers becomes relevant.

Latency issues can cause wagers to be thrown out because they were made after the close of the wagering window, even though the user was not aware this was the case. This can lead to frustration and disenchantment of the users with the system.

Currently, an issue with wagering platforms and applications is that there is no system to authenticate large bets if the user is logged into the platform or application.

Further, wagering platforms and applications lack preferences set by the user to request a reconfirmation of a large wager. The user is left to trust themselves not to place wagers that are too large.

Lastly, there is no way to prompt a user to identify themselves if a large wager is placed in a short amount of time.

Thus, there is a need in the prior art to have a system in place to authenticate large bets places by users on a wagering platform or application.

Currently, an issue with wagering applications is that the user interfaces are identical despite the different locations of the users, leaving the user with the same interface and same functionality despite using the wagering application in different states, cities, arenas, stadiums, restaurants, or bars.

Another issue with wagering applications is that they do not utilize the location data of the user's mobile device besides determining if wagering is allowed in the user's current location.

Lastly, the wagering applications user interface remains static and unchanged despite the environment around the user constantly changing. The limited functionality of the wagering applications prevents various 3rd parties from incorporating additional functions into the wagering application based upon the user's physical location.

An issue with wagering applications and platforms is that they provide generic incentives to increase user engagement, most of which are not tailored to the user's behavior.

Also, most wagering applications provide incentives for signing up for the application but do not provide many other incentive options to increase user engagement.

Lastly, wagering applications offer big incentives such as large sums of money or expensive trips, but these incentives are more focused on expert users who already have high engagement with the application, and there are limited options, along with limited chances to win the casual or beginner users.

Currently, an issue with wagering platforms or wagering applications is that the odds are created from only one data source.

Also, problems may occur when the data source sends incorrect or inaccurate information from a live event, such as an incorrect score or time remaining, incorrect players, etc.

Lastly, there is currently no solution to allow wagering platforms to switch or alter the data sources used to calculate odds.

Thus, there is a need in the prior art to provide the ability to change or switch the data source based on the demands of a wagering platform.

Currently, an issue with wagering platforms and wagering applications is that there is no method for a user to propose a wager to the platforms or applications.

Also, a user may want to customize the wager and offer the wager to multiple sportsbooks to see if they can receive better odds or receive an option to bet more than other sportsbooks allow.

Lastly, there is currently no method to allow sportsbooks to view, review, and bid on customized wagers by users.

The legal definition of gambling can vary from one legal jurisdiction to another. Some jurisdictions may not allow some or even all forms of gambling.

For users who want to continue making wagers when traveling, this creates an issue when the user moves into a place where the form of gambling they are used to is illegal.

In jurisdictions where gambling is legal, it is still important to promote safe, responsible gambling practices. Gambling addiction is one of the reasons gambling is illegal in many jurisdictions.

An issue with wagering platforms or wagering applications is that there is no way to help users hedge their wagers.

Also, there is currently no way to provide the user with similar wagers in other events that may allow them to hedge their current wagers.

Lastly, if the user knows how to hedge their wagers, the system does not provide the user with increased odds to try and win some of their money back, resulting in the user not wagering any more money.

Thus, there is a need in the prior art to provide the user with similar wagers in other events with increase odds to allow the user to hedge their current wagers.

Calculating odds from historical data requires a large sample size of that data to be accurate.

One problem is that records of historical data take time to gather naturally. Thus, it is more efficient to use a dataset that has already been collected in the past.

Assessing which of these past datasets to use can also be problematic. Each dataset may have advantages and disadvantages when compared to another. For example, one dataset may collect more parameters than another, but because it was created later, it does not go back as far historically.

The difficulty of choice increases with the number of options presented. Users can often be distracted when presented with options, even if they would not choose them or the options are irrelevant.

Reducing the number of options, a user has to choose from or presenting a few options at a time can make selections easier and quicker.

When many possible wagers are generated based on the state of a live event, there may naturally be too many for a user to select from easily. Options must be organized based on factors such as which options preclude others, which options can be grouped, and which options match the user's preferences.

A method of displaying available micro-markets on an event in a sequence that maximizes the number of wagers the user could make. For example, at-bat level wagers first, then pitch to pitch wagers second.

Currently, on wagering networks, the user experience may be interrupted due to loss of a signal, cellular data, Wi-Fi, other networking capabilities, etc. while the user is trying to place a wager which may cause frustration for the user if they have placed a wager.

Also, users' connections may drop immediately after the wager has been placed, leaving the user confused about why their wager was not placed.

Lastly, there is currently no way to determine if the user had placed a wager or tried to place a wager, and loss a connection to a wagering network at the moment of connection loss, leaving the wagering network with a loss in potential action.

Thus, there is a need in the prior art to determine if the user had lost connection and did place a wager before the market for the wager was closed.

Currently, an issue on wagering platforms and wagering applications is that many available content features cause connectivity issues if the user's device has poor latency.

Also, if the user has poor latency from the many available features, the user may not select and confirm wagers on the platform or application before the wagering market closes.

Lastly, there is currently no way to provide the user with fewer content features to compensate for poor latency.

Thus, there is a need in the prior art to optimize a wagering platform to provide the user with features that are compatible with the user's device's current latency.

The difficulty of choice increases with the number of options presented. Users can often be distracted when presented with options, even if they would not choose them or the options are irrelevant.

When many possible wagers are generated based on the state of a live event, there may naturally be too many for a user to select from easily. Options must be organized based on factors such as which options preclude others, which options can be grouped, and which options match the user's preferences.

Text-based option selection may slow down or clutter user experience, especially when using a handheld mobile device or device with limited screen space. Because of this, alternate display methods may be needed to facilitate option selection ease and speed.

An alternate display method that shows available wagers wherein subsets of available micro markets are sorted by the player type involved may be beneficial. Users may be able to scroll through representations of those types of players and select a representation to access those wagers.

Participants in wagering games can often become burnt out or cautious about betting after a streak of bad luck. This problem may be exacerbated with micro-wagering because of the quick succession of wagers.

It may be critical to show bettors how other bettors on the platform or the market are wagering. Displaying the amount of action on either side of a wagering market may encourage and be a useful guide for new and experienced bettors by reassuring them that they are not alone in their bad luck.

However, always showing this information may not be ideal as bettors may become desensitized. Further, there may be cases where participants incentivized to place a wager may be discouraged by being shown their wager is unpopular.

Currently, on wagering platforms or wagering applications, users cannot modify a wager once confirmed.

Also, the only method in which a user can try to modify a wager is to hedge their wager, essentially canceling out any potential win or loss.

Lastly, there is no method in which a user can use wager statistics to modify a wager after the wager has been placed.

There is no easy method to predict how users will wager on possible wager outcomes on wagering platforms and wagering applications.

Also, there is no easy method to predict or forecast how much money will be wagered by the users.

Lastly, there is no way to forecast user behavior and update or alter the wagering odds before the odds being released to the public.

Thus, there is a need within the prior art to provide a method to alter the wager odds based on predictions of how users will react and wager to wager odds.

Currently, an issue with wagering platforms and applications is that they do not incorporate data from other wagering platforms or applications.

Also, wagering platforms do not adjust odds based on the number of users currently using a wagering application.

Lastly, wagering platforms do not try to target users by adjusting odds based on how many users are currently using a wagering application.

Thus, there is a need in the prior art to use data on a first wagering network and adjust odds on a second wagering network based on the odds data of the first wagering network.

There are numerous ways to calculate odds on a single play's potential outcomes in a sporting event. Determining the proper odds-making formula to use in each context is an important choice for a sportsbook. Formulas could be, for example, formulas that are in and of themselves computer program modules designed to find profitable sports betting opportunities. They use vast amounts of data from past sporting matches to identify patterns, then calculate the probability of specific sporting outcomes. In most cases, primary betting algorithms calculate the likelihood of various outcomes and compare those probabilities to bookmakers' odds to identify bets that are worth placing.

Betting lines aren't designed to reflect the real and accurate probability of either outcome. Users attempt to gain an edge over sportsbooks by making a wager when they think there is a discrepancy between an event's actual probability and the implied probability determined from a betting line. Current odds making is just as much a risk management proposition as it is a method of predicting sporting events.

As more investment is made in play-to-play sports betting, there is a bigger need to ensure that calculated odds, used in the sports betting platforms, are optimized for both enticing bettors and guaranteeing the house wins. The best algorithms need to be available to ensure the bets are enticing thereby ensuring profits for the game platform owners.

Currently, odds betting programs have relied on trade secret algorithms based upon evaluating historical data to develop the best odds calculations given to players to gamble. The best algorithms need to be available to ensure the bets are enticing thereby ensuring profits for the game platform owners. Historical data may be used in each calculation to improve the precision of the odds calculations.

Odds betting on play-by-play possibilities is new and allows for specific bets to be made, for instance, betting on the next pitch at a baseball game or the next pass or run of a football game. Given that there are so many play-by-play possibilities, all with large historical data, it becomes harder to calculate all the possibilities to create the best odds. What is needed is to deal with an increasing amount of data to calculate the best odds.

Artificial Intelligence (“AI”) is now being pursued to evaluate the big data associated with the large data to be analyzed on play-by-play betting to calculate the best odds. However, to be accurate, AI needs to have sufficient data to perform machine learning and train a model to estimate future odds. Unlike using AI to exercise its models against big data for research, play-by-play sports betting must be done in real-time and typically within seconds. What is required to create odds in real time on big play-by-play data requires enhanced computing capability beyond machine language models.

Artificial Intelligence is now being pursued to evaluate the big data associated with the large data to be analyzed on play-by-play betting to calculate the best odds. However, to be accurate, AI needs to have sufficient data to perform correlations and train a model to estimate future odds. Unlike using AI to exercise its models against big data for research, play-by-play sports betting must be done in real-time and typically within seconds. What is required to create odds in real time on big play-by-play data requires enhanced computing capability beyond correlations models.

### SUMMARY

Embodiments include a method, system, and apparatus for collecting, manipulating, transmitting, and interpreting data. In one embodiment, a plurality of sensors configured to capture real-time sensor data from a live event including a plurality of actions; one or more sport gaming platforms, and a user device, where the one or more sports gaming platforms are configured to: receive and store the captured sensor data, filter a historical sensor database on similar event data matching an ID for an upcoming action, wherein the ID identifies odds on upcoming plays, determine, based on artificial intelligence and/or machine learning and before occurrence of the upcoming action, that there is a high correlation between the captured sensor data and the similar event data, determine a probability of occurrence of the upcoming play associated with the wager ID, and update odds offered by the exchange system.

### BRIEF DESCRIPTION OF THE FIGURES

FIG. 1 illustrates methods and systems for sensor wagers, according to an embodiment.

FIG. 2 illustrates an action module, according to an embodiment.

FIG. 3 illustrates an action database, according to an embodiment.

FIG. 4 illustrates a data collection module, according to an embodiment.

FIG. 5 illustrates a historical sensor database, according to an embodiment.

FIG. 6 illustrates a sensor wager module, according to an embodiment.

FIG. 7 illustrates a wager database, according to an embodiment.

FIG. 8 illustrates a system for play-by-play wager wagering through a wearable device, according to an embodiment.

FIG. 9 illustrates a base module, according to an embodiment.

FIG. 10 illustrates a data capture module, according to an embodiment.

FIG. 11 illustrates an odds calculation module, according to an embodiment.

FIG. 12 illustrates a wager module, according to an embodiment.

FIG. 13 illustrates a wallet database, according to an embodiment.

FIG. 14 illustrates a data feed database, according to an embodiment.

FIG. 15 illustrates a personalized wagering on live events, according to an embodiment.

FIG. 16 illustrates an eligible bet database, according to an embodiment.

FIG. 17 illustrates a historic play database, according to an embodiment.

FIG. 18 illustrates an odds calculation module, according to an embodiment.

FIG. 19 illustrates a base module, according to an embodiment.

FIG. 20 illustrates a wager history database, according to an embodiment.

FIG. 21 illustrates a user interaction module, according to an embodiment.

FIG. 22 illustrates a user interaction database, according to an embodiment.

FIG. 23 illustrates an advertising via a live event wagering platform, according to an embodiment.

FIG. 24 illustrates a base module, according to an embodiment.

FIG. 25 illustrates an advertiser module, according to an embodiment.

FIG. 26 illustrates an advertisement database, according to an embodiment.

FIG. 27 illustrates a bettor interaction database, according to an embodiment.

FIG. 28 illustrates a bettor information database, according to an embodiment.

FIG. 29 illustrates a system using sensors to improve odds, according to an embodiment.

FIG. 30 illustrates a base module, according to an embodiment.

FIG. 31 illustrates a wager module, according to an embodiment.

FIG. 32 illustrates a wager adjustment module, according to an embodiment.

FIG. 33 illustrates a historic sensor database, according to an embodiment.

FIG. 34 illustrates a wager adjustment database, according to an embodiment.

FIG. 35 illustrates a current wagers database, according to an embodiment.

FIG. 36 illustrates an example of a wager module, according to an embodiment.

FIG. 37 illustrates a system for a concession, merchandise, and sponsored wagers, according to an embodiment.

FIG. 38 illustrates a bet database, according to an embodiment.

FIG. 39 illustrates a prize database, according to an embodiment.

FIG. 40 illustrates a sponsor database, according to an embodiment.

FIG. 41 illustrates a base module, according to an embodiment.

FIG. 42 illustrates a bet module, according to an embodiment.

FIG. 43 illustrates a prize module, according to an embodiment.

FIG. 44 illustrates a sponsor module, according to an embodiment.

FIG. 45 illustrates a system for a micro-event individualized odds adjuster, according to an embodiment.

FIG. 46 illustrates a server base module, according to an embodiment.

FIG. 47 illustrates a bet options module, according to an embodiment.

FIG. 48 illustrates a bet database, according to an embodiment.

FIG. 49 illustrates a user odds adjuster module, according to an embodiment.

FIG. 50 illustrates a base module, according to an embodiment.

FIG. 51 illustrates a system for improving odds based on physiological data, according to an embodiment.

FIG. 52 illustrates a base module, according to an embodiment.

FIG. 53 illustrates an odds update module, according to an embodiment.

FIG. 54 illustrates an adjustment module, according to an embodiment.

FIG. 55 illustrates a historic database, according to an embodiment.

FIG. 56 illustrates a potential results database, according to an embodiment.

FIG. 57 illustrates a bet database, according to an embodiment.

FIG. 58 illustrates an example of an odds update module, according to an embodiment.

FIG. 59 illustrates a system for an artificial intelligence based live game wager system, according to an embodiment.

FIG. 60 illustrates a live event module, according to an embodiment.

FIG. 61 illustrates a live event database, according to an embodiment.

FIG. 62 illustrates a base module, according to an embodiment.

FIG. 63 illustrates an odds module, according to an embodiment.

FIG. 64 illustrates a bet module, according to an embodiment.

FIG. 65 illustrates a historic action database, according to an embodiment.

FIG. 66 illustrates a recommendation database, according to an embodiment.

FIG. 67 illustrates a bet database, according to an embodiment.

FIG. 68 illustrates an adjustment database, according to an embodiment.

FIG. 69A illustrates an example of an odds module, according to an embodiment.

FIG. 69B illustrates an example of an odds module, according to an embodiment.

FIG. 70A illustrates another example of an odds module, according to an embodiment.

FIG. 70B illustrates another example of an odds module, according to an embodiment.

FIG. 71 Illustrates a Real Time Action of Interest Notification System, according to an embodiment.

FIG. 72 Illustrates a Betting Module, according to an embodiment.

FIG. 73 Illustrates a Notification Module, according to an embodiment.

FIG. 74 Illustrates a User History Database, according to an embodiment.

FIG. 75 illustrates an artificial intelligence based live game wager adjuster, according to an embodiment.

FIG. 76 illustrates a base module, according to an embodiment.

FIG. 77 illustrates a wager module, according to an embodiment.

FIG. 78 illustrates a wager adjustment module, according to an embodiment.

FIG. 79 illustrates a historic bet database, according to an embodiment.

FIG. 80 illustrates a threshold database, according to an embodiment.

FIG. 81 illustrates a bet database, according to an embodiment.

FIG. 82 illustrates a wager adjustment database, according to an embodiment.

FIG. 83A illustrates an example of a wager module, according to an embodiment.

FIG. 83B illustrates another example of a wager module, according to an embodiment.

FIG. 84 illustrates a system for a community-based event driven wagering platform, according to an embodiment.

FIG. 85 illustrates a user database, according to an embodiment.

FIG. 86 illustrates a base wagering module, according to an embodiment.

FIG. 87 illustrates a community building module, according to an embodiment.

FIG. 88 illustrates a leaderboard module, according to an embodiment.

FIG. 89 illustrates a peer to peer module, according to an embodiment.

FIG. 90 illustrates a system for a play by play parlay, according to an embodiment.

FIG. 91 illustrates a base wagering module, according to an embodiment.

FIG. 92 illustrates a parlay module, according to an embodiment.

FIG. 93 illustrates a historical play database, according to an embodiment.

FIG. 94 illustrates a parlay payout table, according to an embodiment.

FIG. 95 illustrates a system for an interactive display for in-play wagering, according to an embodiment.

FIG. 96 illustrates a base module, according to an embodiment.

FIG. 97 illustrates a pairing module, according to an embodiment.

FIG. 98 illustrates a display module, according to an embodiment.

FIG. 99 illustrates a wagering module, according to an embodiment.

FIG. 100 illustrates a system for an AR VR In-Play Wagering System, according to an embodiment.

FIG. 101 illustrates a base wagering module, according to an embodiment.

FIG. 102 illustrates a reality wagering module, according to an embodiment.

FIG. 103 illustrates a wager adjustment module, according to an embodiment.

FIG. 104 illustrates a multiplier database, according to an embodiment.

FIG. 105 illustrates a current wager database, according to an embodiment.

FIG. 106 illustrates a system for tracking user bets to ensure compliance, according to an embodiment.

FIG. 107 illustrates a user database, according to an embodiment.

FIG. 108 illustrates an odds database, according to an embodiment.

FIG. 109 illustrates a user behavior module, according to an embodiment.

FIG. 110 illustrates a threshold module, according to an embodiment.

FIG. 111 illustrates a cheating module, according to an embodiment.

FIG. 112 illustrates a system for an AI-based path wagering, according to an embodiment.

FIG. 113 illustrates a current wager database, according to an embodiment.

FIG. 114 illustrates a path wagering module, according to an embodiment.

FIG. 115 illustrates an AI vision module, according to an embodiment.

FIG. 116 illustrates a system for a third party analytics integration into a wagering platform, according to an embodiment.

FIG. 117 illustrates a user database, according to an embodiment.

FIG. 118 illustrates a display module, according to an embodiment.

FIG. 119 illustrates a subscription module, according to an embodiment.

FIG. 120 illustrates a system for 3rd Party Analytics Integration into a wagering platform, according to an embodiment.

FIG. 121 illustrates a user database, according to an embodiment.

FIG. 122 illustrates a wagering module, according to an embodiment.

FIG. 123 illustrates a verify module, according to an embodiment.

FIG. 124 illustrates a payout module, according to an embodiment.

FIG. 125 illustrates an account database, according to an embodiment.

FIG. 126 illustrates a system for a player focused wagering system, according to an embodiment.

FIG. 127 illustrates a user database, according to an embodiment.

FIG. 128 illustrates a wagering module, according to an embodiment.

FIG. 129 illustrates a favorites module, according to an embodiment.

FIG. 130 illustrates a tiered wagering module, according to an embodiment.

FIG. 131 illustrates a tier database, according to an embodiment.

FIG. 132 illustrates a system for a wager sharing and invitation method, according to an embodiment.

FIG. 133 illustrates a user database, according to an embodiment.

FIG. 134 illustrates a base wagering module, according to an embodiment.

FIG. 135 illustrates a wager sharing module, according to an embodiment.

FIG. 136 illustrates a wager receiving module, according to an embodiment.

FIG. 137 illustrates a system for an AI sports betting algorithms engine, according to an embodiment.

FIG. 138 illustrates a cross database, according to an embodiment.

FIG. 139 illustrates a base module, according to an embodiment.

FIG. 140 illustrates a betting algorithms module, according to an embodiment.

FIG. 141 illustrates a cross module, according to an embodiment.

FIG. 142 illustrates an AI comparison module, according to an embodiment.

FIG. 143 illustrates a final odds module, according to an embodiment.

FIG. 144 illustrates a machine learning module, according to an embodiment.

FIG. 145 illustrates a system for a wager odds balancing method, according to an embodiment.

FIG. 146 illustrates a current wagers database, according to an embodiment.

FIG. 147 illustrates a base wagering module, according to an embodiment.

FIG. 148 illustrates a odds balancing module, according to an embodiment.

FIG. 149 illustrates a system for an incremental wager method, according to an embodiment.

FIG. 150 illustrates a historical wager database, according to an embodiment.

FIG. 151 illustrates a base wagering module, according to an embodiment.

FIG. 152 illustrates a wager increase module, according to an embodiment.

FIG. 153 illustrates a system for an automatic wager method, according to an embodiment.

FIG. 154 illustrates a historical wager database, according to an embodiment.

FIG. 155 illustrates a base wagering module, according to an embodiment.

FIG. 156 illustrates a wager proposal module, according to an embodiment.

FIG. 157 illustrates a system for in-play wagering through a fantasy sports network, according to an embodiment.

FIG. 158 illustrates a base fantasy module, according to an embodiment.

FIG. 159 illustrates a wagering module, according to an embodiment.

FIG. 160 illustrates a system for casino gaming during breaks in live sporting event, according to an embodiment.

FIG. 161 illustrates a base wagering module, according to an embodiment.

FIG. 162 illustrates a wagering module, according to an embodiment.

FIG. 163 illustrates a casino games module, according to an embodiment.

FIG. 164 illustrates a system for wagering, according to an embodiment.

FIG. 165 illustrates a historical wagering database, according to an embodiment.

FIG. 166 illustrates a recording database, according to an embodiment.

FIG. 167 illustrates a base wagering module, according to an embodiment.

FIG. 168 illustrates a wager significance module, according to an embodiment.

FIG. 169 illustrates a system for a player focused wagering system, according to an embodiment.

FIG. 170 illustrates a risk adjusted odds database, according to an embodiment.

FIG. 171 illustrates a primary risk module, according to an embodiment.

FIG. 172 illustrates a data risk module, according to an embodiment.

FIG. 173 illustrates a range risk module, according to an embodiment.

FIG. 174 illustrates a loss risk module, according to an embodiment.

FIG. 175 illustrates a system for a wager reward method, according to an embodiment.

FIG. 176 illustrates a historical wager database, according to an embodiment.

FIG. 177 illustrates a base wagering module, according to an embodiment.

FIG. 178 illustrates a bettor classification module, according to an embodiment.

FIG. 179 illustrates a large bettor database, according to an embodiment.

FIG. 180 illustrates an incentive module, according to an embodiment.

FIG. 181 illustrates an incentive assessment module, according to an embodiment.

FIG. 182A illustrates an embodiment of an incentive database, according to an embodiment.

FIG. 182B illustrates an embodiment of an incentive database, according to an embodiment.

FIG. 182C illustrates an embodiment of an incentive database, according to an embodiment.

FIG. 182D illustrates an embodiment of an incentive database, according to an embodiment.

FIG. 183 illustrates a system for a method of displaying a notification from a betting application using AI that can impact normal betting, according to an embodiment.

FIG. 184 illustrates a risk limits database, according to an embodiment.

FIG. 185 illustrates a system risk module, according to an embodiment.

FIG. 186 illustrates an exposure mitigation module, according to an embodiment.

FIG. 187 illustrates a bet finder module, according to an embodiment.

FIG. 188 illustrates a notification module, according to an embodiment.

FIG. 189 illustrates a system for wagering system that provides for replaying certain bets, according to an embodiment.

FIG. 190 illustrates an event wager database, according to an embodiment.

FIG. 191 illustrates a recording database, according to an embodiment.

FIG. 192 illustrates a base wagering module, according to an embodiment.

FIG. 193 illustrates a wager review module, according to an embodiment.

FIG. 194 illustrates a clip database, according to an embodiment.

FIG. 195 illustrates a system for a wager replaying and sharing system, according to an embodiment.

FIG. 196 illustrates a user database, according to an embodiment.

FIG. 197 illustrates an event wager database, according to an embodiment.

FIG. 198 illustrates a recording database, according to an embodiment.

FIG. 199 illustrates a base wagering module, according to an embodiment.

FIG. 200 illustrates a wager sharing module, according to an embodiment.

FIG. 201 illustrates a wager receiving module, according to an embodiment.

FIG. 202 illustrates a clip database, according to an embodiment.

FIG. 203: Illustrates a method of displaying a notification from a betting application using AI that can impact normal betting, according to an embodiment.

FIG. 204: Illustrates a betting algorithms module, according to an embodiment.

FIG. 205: Illustrates a cross module, according to an embodiment.

FIG. 206: Illustrates a cross database, according to an embodiment.

FIG. 207: Illustrates a final odds module, according to an embodiment.

FIG. 208: Illustrates an AI comparison module, according to an embodiment.

FIG. 209: Illustrates a machine learning module, according to an embodiment.

FIG. 210: Illustrates an odds adjustment module, according to an embodiment.

FIG. 211: Illustrates an odds adjustment database, according to an embodiment.

FIG. 212 illustrates a system for in-play wagering through an odds marketplace network, according to an embodiment.

FIG. 213 illustrates a wagering network module, according to an embodiment.

FIG. 214 illustrates a user module, according to an embodiment.

FIG. 215 illustrates a settlement module, according to an embodiment.

FIG. 216 illustrates a system for a player focused wagering system, according to an embodiment.

FIG. 217 illustrates an available wagers database, according to an embodiment.

FIG. 218 illustrates an escrow database, according to an embodiment.

FIG. 219 illustrates a wagering module, according to an embodiment.

FIG. 220 illustrates a settlement module, according to an embodiment.

FIG. 221 illustrates a system for a player focused wagering system, according to an embodiment.

FIG. 222 illustrates a historical wager database, according to an embodiment.

FIG. 223 illustrates a base wagering module, according to an embodiment.

FIG. 224 illustrates a wager offer module, according to an embodiment.

FIG. 225 illustrates a system for automated wager detection, according to an embodiment.

FIG. 226 illustrates a historical wager database, according to an embodiment.

FIG. 227 illustrates a base wagering module, according to an embodiment.

FIG. 228 illustrates an automation detection module, according to an embodiment.

FIG. 229 illustrates a system for in-play wagering through a wagering network, according to an embodiment.

FIG. 230 illustrates a base wagering module, according to an embodiment.

FIG. 231 illustrates a wagering module, according to an embodiment.

FIG. 232 illustrates a data selection module, according to an embodiment.

FIG. 233: Illustrates a system for voice-based wagering, according to an embodiment.

FIG. 234: Illustrates a base wagering module, according to an embodiment.

FIG. 235: Illustrates a wager search module, according to an embodiment.

FIG. 236: Illustrates a player search module, according to an embodiment.

FIG. 237: Illustrates an understanding module, according to an embodiment.

FIG. 238: illustrates a system for displaying news related to a wager, according to an embodiment.

FIG. 239: illustrates a news module, according to an embodiment.

FIG. 240: illustrates a news database, according to an embodiment.

FIG. 241: illustrates a method for performing analytics on a user's wagering history, according to an embodiment.

FIG. 242: illustrates a base module, according to an embodiment.

FIG. 243: illustrates a cohort module, according to an embodiment.

FIG. 244: illustrates a user analytics module, according to an embodiment.

FIG. 245: illustrates a cohort analytics module, according to an embodiment.

FIG. 246: illustrates a cohort database, according to an embodiment.

FIG. 247: illustrates a cohort creation system, according to an embodiment.

FIG. 248: illustrates a base module, according to an embodiment.

FIG. 249: illustrates a click data module, according to an embodiment.

FIG. 250: illustrates an incentive module, according to an embodiment.

FIG. 251: illustrates a base module, according to an embodiment.

FIG. 252: illustrates a data collection module, according to an embodiment.

FIG. 253: illustrates a correlation module, according to an embodiment.

FIG. 254: illustrates a cohort module, according to an embodiment.

FIG. 255: illustrates a click database, according to an embodiment.

FIG. 256: illustrates a correlations database, according to an embodiment.

FIG. 257: illustrates an incentive database, according to an embodiment.

FIG. 258 illustrates a system for lineup-based odds adjustment, according to an embodiment.

FIG. 259 illustrates an odds adjustment module, according to an embodiment.

FIG. 260 illustrates a lineup database, according to an embodiment.

FIG. 261: illustrates a system for displaying individual jackpots to increase user engagement, according to an embodiment.

FIG. 262: illustrates a progressive offer module, according to an embodiment.

FIG. 263: illustrates a progressive database, according to an embodiment.

FIG. 264: illustrates a betting accrue module, according to an embodiment.

FIG. 265: illustrates a progress display module, according to an embodiment.

FIG. 266: illustrates a game prize module, according to an embodiment.

FIG. 267: illustrates a system for an at-bat/per drive wagering, according to an embodiment.

FIG. 268: illustrates a next plays wager module, according to an embodiment.

FIG. 269: illustrates a player lineup database, according to an embodiment.

FIG. 270 illustrates a system for uncommon bet notifications, according to an embodiment.

FIG. 271 illustrates a base module, according to an embodiment.

FIG. 272 illustrates a single bet check module, according to an embodiment.

FIG. 273 illustrates a sequence bet check module, according to an embodiment.

FIG. 274 illustrates a pattern bet check module, according to an embodiment.

FIG. 275 illustrates an alert module, according to an embodiment.

FIG. 276 illustrates a check bet database, according to an embodiment.

FIG. 277: illustrates a system for suspending a micro-market through a visual indicator, according to an embodiment.

FIG. 278: illustrates a market suspension module, according to an embodiment.

FIG. 279: illustrates a training module according to an embodiment.

FIG. 280: illustrates a market suspension database, according to an embodiment.

FIG. 281 illustrates a system for group wagering with a progressive jackpot, according to an embodiment.

FIG. 282 illustrates a group base module, according to an embodiment.

FIG. 283 illustrates a group join module, according to an embodiment.

FIG. 284 illustrates a group wager module, according to an embodiment.

FIG. 285 illustrates a group jackpot module, according to an embodiment.

FIG. 286 illustrates a group database, according to an embodiment.

FIG. 287 illustrates a system for dual-stream video and wager data, according to an embodiment.

FIG. 288 illustrates a dual-stream base module, according to an embodiment.

FIG. 289 illustrates a media stream module, according to an embodiment.

FIG. 290 illustrates a wager stream module, according to an embodiment.

FIG. 291 illustrates an integration module, according to an embodiment.

FIG. 292 illustrates a system for odds making through context-specific simulations, according to an embodiment.

FIG. 293 illustrates a simulation base module, according to an embodiment.

FIG. 294 illustrates an initial simulation module, according to an embodiment.

FIG. 295 illustrates a simulation update module, according to an embodiment.

FIG. 296 illustrates a stimulation adjustment module, according to an embodiment.

FIG. 297 illustrates a simulation database, according to an embodiment.

FIG. 298: Illustrates a system for voice-based wagering, according to an embodiment.

FIG. 299: Illustrates a base wagering module, according to an embodiment.

FIG. 300: Illustrates a generic odds module, according to an embodiment.

FIG. 301: Illustrates a team odds module, according to an embodiment.

FIG. 302: Illustrates a player odds module, according to an embodiment.

FIG. 303: Illustrates a filtered odds module, according to an embodiment.

FIG. 304: Illustrates a hybrid odds module, according to an embodiment.

FIG. 305: Illustrates a bettor odds module, according to an embodiment.

FIG. 306 illustrates a system for a method of displaying a notification from a betting application using AI that can impact normal betting, according to an embodiment.

FIG. 307 illustrates a risk limits database, according to an embodiment.

FIG. 308 illustrates a system risk module, according to an embodiment.

FIG. 309 illustrates an exposure mitigation module, according to an embodiment.

FIG. 310 illustrates a bet finder module, according to an embodiment.

FIG. 311 illustrates a notification module, according to an embodiment.

FIG. 312 illustrates a system for a customized rolling ticker feed, according to an embodiment.

FIG. 313 illustrates a base wagering module, according to an embodiment.

FIG. 314 illustrates a preferences module, according to an embodiment.

FIG. 315 illustrates a ticker prioritization module, according to an embodiment.

FIG. 316 illustrates a ticker database, according to an embodiment.

FIG. 317 Illustrates a system for offering a subsequent event parlay wagering, according to an embodiment.

FIG. 318 Illustrates a parlay offer module, according to an embodiment.

FIG. 319 Illustrates a live event database, according to an embodiment.

FIG. 320 illustrates a method for determining a user's long-term value and finding a similar new user, according to an embodiment.

FIG. 321 illustrates a base module, according to an embodiment.

FIG. 322 illustrates an LTV module, according to an embodiment.

FIG. 323 illustrates a user engagement module, according to an embodiment.

FIG. 324 illustrates a cohort module, according to an embodiment.

FIG. 325 illustrates a user correlation module, according to an embodiment.

FIG. 326 illustrates a new user correlation module, according to an embodiment.

FIG. 327 illustrates a user similarity module, according to an embodiment.

FIG. 328 illustrates a cohort database, according to an embodiment.

FIG. 329 illustrates a user correlation database, according to an embodiment.

FIG. 330 illustrates a new correlation database, according to an embodiment.

FIG. 331 illustrates a system for a real-time odds change indicator, according to an embodiment.

FIG. 332 illustrates an odds change display module, according to an embodiment.

FIG. 333 illustrates a system for indirect odds making, according to an embodiment.

FIG. 334 illustrates a base module, according to an embodiment.

FIG. 335 illustrates a user prediction module, according to an embodiment.

FIG. 336 illustrates a wager prediction module, according to an embodiment.

FIG. 337 illustrates an alter odds module, according to an embodiment.

FIG. 338 illustrates a user bet database, according to an embodiment.

FIG. 339 illustrates a user prediction database, according to an embodiment.

FIG. 340 illustrates a wager prediction database, according to an embodiment.

FIG. 341 illustrates a rules database, according to an embodiment.

FIG. 342 illustrates a substitute data module, according to an embodiment.

FIG. 343 illustrates a system for creating new wagers and optimize odds in an online play-by-play sports betting game, according to an embodiment.

FIG. 344 illustrates a base module, according to an embodiment.

FIG. 345 illustrates a first sequence module, according to an embodiment.

FIG. 346 illustrates an additional sequence module, according to an embodiment.

FIG. 347 illustrates a system for displaying news related to a player, according to an embodiment.

FIG. 348 illustrates a player news module, according to an embodiment.

FIG. 349 illustrates a news database, according to an embodiment.

FIG. 350 illustrates a player follower database, according to an embodiment.

FIG. 351 illustrates a player wager module, according to an embodiment.

FIG. 352 illustrates a system for in-play wagering for contest prizes by wins, according to an embodiment.

FIG. 353 illustrates a base module, according to an embodiment.

FIG. 354 illustrates a cohort module, according to an embodiment.

FIG. 355 illustrates a contest module, according to an embodiment.

FIG. 356 illustrates a prize module, according to an embodiment.

FIG. 357 illustrates a cohort database, according to an embodiment.

FIG. 358 illustrates a contest database, according to an embodiment.

FIG. 359 illustrates a system for in-play wagering for contest prizes by points, according to an embodiment.

FIG. 360 illustrates a base module, according to an embodiment.

FIG. 361 illustrates a cohort module, according to an embodiment.

FIG. 362 illustrates a contest module, according to an embodiment.

FIG. 363 illustrates a prize module, according to an embodiment.

FIG. 364 illustrates a cohort database, according to an embodiment.

FIG. 365 illustrates a contest database, according to an embodiment.

FIG. 366 illustrates a system for haptic wager notification, according to an embodiment.

FIG. 367 illustrates a base wagering module, according to an embodiment.

FIG. 368 illustrates a preferences module, according to an embodiment.

FIG. 369 illustrates a notification module, according to an embodiment.

FIG. 370 illustrates a notification database, according to an embodiment.

FIG. 371 illustrates a method for storing wagering data locally, according to an embodiment.

FIG. 372 illustrates a data collection module, according to an embodiment.

FIG. 373 illustrates a viewer module, according to an embodiment.

FIG. 374 illustrates a send data module, according to an embodiment.

FIG. 375 illustrates a user data comparison system, according to an embodiment.

FIG. 376 illustrates a base module, according to an embodiment.

FIG. 377 illustrates a contact module, according to an embodiment.

FIG. 378 illustrates a leaderboard module, according to an embodiment.

FIG. 379 illustrates a contact database, according to an embodiment.

FIG. 380 illustrates a system for an on-deck wagering system, according to an embodiment.

FIG. 381 illustrates a next play wager module, according to an embodiment.

FIG. 382 illustrates a next players module, according to an embodiment.

FIG. 383 illustrates a next plays module, according to an embodiment.

FIG. 384 illustrates a system for notifications for known contact(s) or friend(s) wagers, according to an embodiment.

FIG. 385 illustrates an add friends module, according to an embodiment.

FIG. 386 illustrates a contact database, according to an embodiment.

FIG. 387 illustrates a wager indicator module, according to an embodiment.

FIG. 388 illustrates a system for rolling plays in a drive wager, according to an embodiment.

FIG. 389 illustrates a base module, according to an embodiment.

FIG. 390 illustrates a drive begins module, according to an embodiment.

FIG. 391 illustrates a drive continuation module, according to an embodiment.

FIG. 392 illustrates a system for providing a user with betting statistics, according to an embodiment.

FIG. 393 illustrates a wager trends base module, according to an embodiment.

FIG. 394 illustrates a relationship module, according to an embodiment.

FIG. 395 illustrates a trend module, according to an embodiment.

FIG. 396 illustrates a notification rules database, according to an embodiment.

FIG. 397 illustrates a system for providing a user with bet-related information prior to placing a real-time bet, according to an embodiment.

FIG. 398 illustrates an odds factor module, according to an embodiment.

FIG. 399 illustrates a factor identification module, according to an embodiment.

FIG. 400 illustrates a factor impact module, according to an embodiment.

FIG. 401 illustrates a system for managing wager micro-markets with artificial intelligence using human traders, according to an embodiment.

FIG. 402 illustrates a base module, according to an embodiment.

FIG. 403 illustrates a wager correlation module, according to an embodiment.

FIG. 404 illustrates an SGO review module, according to an embodiment.

FIG. 405 illustrates an SGO correction database, according to an embodiment.

FIG. 406 illustrates a system for managing wager micro-markets with AI using human traders and weighted datasets, according to an embodiment.

FIG. 407 illustrates a base module, according to an embodiment.

FIG. 408 illustrates an SGO scoring module, according to an embodiment.

FIG. 409 illustrates a wager correlation module, according to an embodiment.

FIG. 410 illustrates an SGO review module, according to an embodiment.

FIG. 411 illustrates an SGO correction database, according to an embodiment.

FIG. 412 illustrates an SGO profit database, according to an embodiment.

FIG. 413 illustrates a system for calculating the odds of a sports play using data fidelity, according to an embodiment.

FIG. 414 illustrates a base module, according to an embodiment.

FIG. 415 illustrates a play accuracy module, according to an embodiment.

FIG. 416 illustrates a system accuracy module, according to an embodiment.

FIG. 417 illustrates a play rules database, according to an embodiment.

FIG. 418 illustrates a system rules database, according to an embodiment.

FIG. 419 illustrates a system for swipe-based wagering, according to an embodiment.

FIG. 420 illustrates a swipe wager module, according to an embodiment.

FIG. 421 illustrates a gesture database, according to an embodiment.

FIG. 422 illustrates a system for using an integrated sports wagering system, according to an embodiment.

FIG. 423 illustrates a sensor data module, according to an embodiment.

FIG. 424 illustrates an event data module according to an embodiment.

FIG. 425 illustrates a system for providing wagering odds without the results of a first play, according to an embodiment.

FIG. 426 illustrates a base module, according to an embodiment.

FIG. 427 illustrates an isolated odds module, according to an embodiment.

FIG. 428 illustrates a comparison module, according to an embodiment.

FIG. 429 illustrates a system for celebrating or taunting users of a wagering network, according to an embodiment.

FIG. 430 illustrates a sportogram base module, according to an embodiment.

FIG. 431 illustrates a subscription module, according to an embodiment.

FIG. 432 illustrates a connection module, according to an embodiment.

FIG. 433 illustrates a monitoring module, according to an embodiment.

FIG. 434 illustrates a delivery module, according to an embodiment.

FIG. 435 illustrates a sportogram database, according to an embodiment.

FIG. 436 illustrates a system for suggesting wagers based on wagers made by contacts, according to an embodiment.

FIG. 437 illustrates a base module, according to an embodiment.

FIG. 438 illustrates a contact module, according to an embodiment.

FIG. 439 illustrates a suggested wager module, according to an embodiment.

FIG. 440 illustrates a contact database, according to an embodiment.

FIG. 441 illustrates a system for balancing local and server-side wagering data based on latency, according to an embodiment.

FIG. 442 illustrates a latency detection module, according to an embodiment.

FIG. 443 illustrates a local data level module, according to an embodiment.

FIG. 444 illustrates a latency level database, according to an embodiment.

FIG. 445 illustrates an adjustment factors database, according to an embodiment.

FIG. 446 illustrates is a system for a latency display on a wagering app, according to an embodiment.

FIG. 447 illustrates a latency detection module, according to an embodiment.

FIG. 448 illustrates a latency display module, according to an embodiment.

FIG. 449 illustrates a latency display database, according to an embodiment.

FIG. 450 illustrates a system for authenticating large bets, according to an embodiment.

FIG. 451 illustrates a settings module, according to an embodiment.

FIG. 452 illustrates a verify module, according to an embodiment.

FIG. 453 illustrates a threshold module, according to an embodiment.

FIG. 454 illustrates an authenticate module, according to an embodiment.

FIG. 455 illustrates a threshold database, according to an embodiment.

FIG. 456 illustrates an authenticate database, according to an embodiment.

FIG. 457 illustrates a system for a location-based wagering interface, according to an embodiment.

FIG. 458 illustrates a location ID module, according to an embodiment.

FIG. 459 illustrates a location interface module, according to an embodiment.

FIG. 460 illustrates a location interface database, according to an embodiment.

FIG. 461 illustrates a system for increasing user engagement by offering incentives to incrementally modify user behavior, according to an embodiment.

FIG. 462 illustrates a base module, according to an embodiment.

FIG. 463 illustrates an incentive correlation module, according to an embodiment.

FIG. 464 illustrates an incentive threshold module, according to an embodiment.

FIG. 465 illustrates a cohort incentive database, according to an embodiment.

FIG. 466 illustrates a system for using multiple data types to calculate odds, according to an embodiment.

FIG. 467 illustrates a base module, according to an embodiment.

FIG. 468 illustrates a data source module, according to an embodiment.

FIG. 469 illustrates a source threshold module, according to an embodiment.

FIG. 470 illustrates a data source database, according to an embodiment.

FIG. 471 illustrates a data threshold database, according to an embodiment.

FIG. 472 illustrates a method for a user to propose a wager to the house, according to an embodiment.

FIG. 473 illustrates a wager criteria module, according to an embodiment.

FIG. 474 illustrates a base module, according to an embodiment.

FIG. 475 illustrates a criteria collection module, according to an embodiment.

FIG. 476 illustrates a wager marketplace module, according to an embodiment.

FIG. 477 illustrates a wager criteria database, according to an embodiment.

FIG. 478 illustrates an offer module, according to an embodiment.

FIG. 479 illustrates a system for disabling cash value wagering, according to an embodiment.

FIG. 480 illustrates a mode switch module, according to an embodiment.

FIG. 481 illustrates a jurisdiction database, according to an embodiment.

FIG. 482 illustrates a responsible gaming database, according to an embodiment.

FIG. 483 illustrates a method for allowing a user to hedge their wagers, according to an embodiment.

FIG. 484 illustrates a base module, according to an embodiment.

FIG. 485 illustrates a user streak module, according to an embodiment.

FIG. 486 illustrates a hedge module, according to an embodiment.

FIG. 487 illustrates an increase odds database, according to an embodiment.

FIG. 488 illustrates a system for odds calculation using multiple data sources, according to an embodiment.

FIG. 489 illustrates a multiple odds calculation module, according to an embodiment.

FIG. 490 illustrates a 3rd party odds database, according to an embodiment.

FIG. 491 illustrates a system for wager presentation order optimization, according to an embodiment.

FIG. 492 illustrates a wager order module, according to an embodiment.

FIG. 493 illustrates a wager relation database, according to an embodiment.

FIG. 494 illustrates a system for verifying that a wager was placed before market close on a play-by-play wagering network, according to an embodiment.

FIG. 495 illustrates a wager placement module, according to an embodiment.

FIG. 496 illustrates a time confirmation module, according to an embodiment.

FIG. 497 illustrates a wager time database, according to an embodiment.

FIG. 498 illustrates a verification module, according to an embodiment.

FIG. 499 illustrates a system for optimizing wagering on a wagering platform, according to an embodiment.

FIG. 500 illustrates a base module, according to an embodiment.

FIG. 501 illustrates a latency module, according to an embodiment.

FIG. 502 illustrates a content module according to an embodiment.

FIG. 503 illustrates a latency database, according to an embodiment.

FIG. 504 illustrates a content database, according to an embodiment.

FIG. 505 illustrates a system for icon-based wager presentation, according to an embodiment.

FIG. 506 illustrates a wager order module, according to an embodiment.

FIG. 507 illustrates a wager relation database, according to an embodiment.

FIG. 508 illustrates a wager icon database, according to an embodiment.

FIG. 509 illustrates a system for using wagering statistics to incentivize wagering, according to an embodiment.

FIG. 510 illustrates a wager incentive module, according to an embodiment.

FIG. 511 illustrates a current wager stats module, according to an embodiment.

FIG. 512 illustrates a historical wager stats module, according to an embodiment.

FIG. 513 illustrates a system for modifying a wager after wager statistics are displayed, according to an embodiment.

FIG. 514 illustrates a wager module, according to an embodiment.

FIG. 515 illustrates a modify module according to an embodiment.

FIG. 516 illustrates a wager statistics module, according to an embodiment.

FIG. 517 illustrates a wager adjustment module, according to an embodiment.

FIG. 518 illustrates a modify database, according to an embodiment.

FIG. 519 a system for A.I.-based changes based on deviations from predictions, according to an embodiment.

FIG. 520 illustrates a base module, according to an embodiment.

FIG. 521 illustrates a user prediction module, according to an embodiment.

FIG. 522 illustrates a wager prediction module, according to an embodiment.

FIG. 523 illustrates an alter odds module, according to an embodiment.

FIG. 524 illustrates a user bet database, according to an embodiment.

FIG. 525 illustrates a user prediction database, according to an embodiment.

FIG. 526 illustrates a wager prediction database, according to an embodiment.

FIG. 527 illustrates a rules database, according to an embodiment.

FIG. 528 illustrates a system for calculating and storing the odds data on a first wagering network and adjusting odds on a second wagering network based on the odds data from the first wagering network, according to an embodiment.

FIG. 529 illustrates an odds information module, according to an embodiment.

FIG. 530 illustrates an odds collection module, according to an embodiment.

FIG. 531 illustrates an odds adjustment module, according to an embodiment.

FIG. 532 illustrates an odds adjustment database, according to an embodiment.

FIG. 533 Illustrates a system for a quantum sports betting algorithms engine, according to an embodiment.

FIG. 534 Illustrates a cross-database, according to an embodiment.

FIG. 535 Illustrates a base module, according to an embodiment.

FIG. 536 Illustrates a betting algorithms module, according to an embodiment.

FIG. 537 Illustrates a cross-module, according to an embodiment.

FIG. 538 Illustrates an AI comparison module, according to an embodiment.

FIG. 539 Illustrates a final odds module, according to an embodiment.

FIG. 540 Illustrates machine learning, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention

As used herein, the word exemplary means serving as an example, instance or illustration. The embodiments described herein are not limiting, but rather are exemplary only. It should be understood that the described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action. As another example a quantum computer can be used to perform searches of data, perform correlations of data, perform machine learning of data. As another example a combination of a classical computer, supercomputer and quantum computer can be used in any combination to perform all of or part of performing searches of data, perform correlations of data, perform machine learning of data.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity on the basis of the outcome of a future event, such as the results of a game or event. It may be understood that non-monetary items may be the subject of a “bet” or “wager” as well, such as points or anything else that can be quantified for a “wager” or “bet.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be done for certain amount or for a future time. A “bet” or “wager” can be done for being able to answer a question correctly. A “bet” or “wager” can be done within a certain period of time. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain for the purpose of placing bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk caters” (often a derogatory term). An event or game in which the sports book has reduced its betting limits, usually because of weather or the uncertain status of injured players is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides”, “favorite”, “chalk”, “circled game”, “laying the points price”, “dog” and “underdog” can be integrated into the embodiments in a variety of manners.

The “money line” refers to the odds expressed in terms of money. With money odds, whenever there is a minus (−) the player “lays” or is “laying” that amount to win (for example $100); where there is a plus (+) the player wins that amount for every $100 wagered. A “straight bet” refers to an individual wager on a game or event that will be determined by a point spread or money line. The term “straight-up” means winning the game without any regard to the “point spread”; a “money-line” bet. “Money line”, “straight bet”, “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread”. A handicap of the “point spread” value is given to the favorite team so bettors can choose sides at equal odds. “Cover the spread” means that a favorite win an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread”. The “opening line” means the earliest line posted for a particular sporting event or game. The term “pick” or “pick'em” refers to a game when neither team is favored in an event or game. “Line”, “cover the spread”, “cover”, “tie”, “pick” and “pick-cm” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules, in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. Event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total”, “over”, and “under” can be integrated into the embodiments in a variety of manners.

A “parlay” is a single bet that links together two or more wagers; to win the bet, the player must win all the wagers in the “parlay”. If the player loses one wager, the player loses the entire bet. However, if he wins all the wagers in the “parlay”, the player wins a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay”, “round robin”, “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events, typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both of the pitchers scheduled to start a game actually start. If they don't, the bet is deemed “no action” and refunded. The “run line” in baseball, refers to a spread used instead of the money line. “Listed pitchers” and “no action” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle”, “juice”, vigorish”, “vig” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individual that would deploy, for fees, and may be part of, of perform, various system elements or method steps in the embodiments.

Managed service user interface service is a service that can help customers (1) manage third parties, (2) develop the web, (3) do data analytics, (4) connect thru application program interfaces and (4) track and report on player behaviors. A managed service user interface can be integrated into the embodiments in a variety of manners.

Managed service risk management services are a service that assists customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling and (4) customer service assistance. These managed service compliance services can be integrated into the embodiments in a variety of manners.

Managed service pricing and trading service is a service that helps customers with (1) official data feeds, (2) data visualization and (3) land based, on property digital signage. These managed service pricing and trading services can be integrated into the embodiments in a variety of manners.

Managed service and technology platform are services that helps customers with (1) web hosting, (2) IT support and (3) player account platform support. These managed service and technology platform services can be integrated into the embodiments in a variety of manners.

Managed service and marketing support services are services that help customers (1) acquire and retain clients and users, (2) provide for bonusing options and (3) develop press release content generation. These managed service and marketing support services can be integrated into the embodiments in a variety of manners.

Payment processing services are those services that help customers that allow for (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat your players to free bets, odds boosts, enhanced access and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by managing commission and availability at all times. The “cash out” or “pay out” or “payout” can be integrated into the embodiments in a variety of manners, including both monetary and non-monetary payouts, such as points, prizes, promotional or discount codes, and the like.

“Customized betting” allow customers to have tailored personalized betting experiences with sophisticated tracking and analysis of players' behavior. “Customized betting” can be integrated into the embodiments in a variety of manners.

Kiosks are devices that offer interactions with customers clients and users with a wide range of modular solutions for both retail and online sports gaming. Kiosks can be integrated into the embodiments in a variety of manners.

Business Applications are an integrated suite of tools for customers to manage the everyday activities that drive sales, profit, and growth, from creating and delivering actionable insights on performance to help customers to manage the sports gaming. Business Applications can be integrated into the embodiments in a variety of manners.

State based integration allows for a given sports gambling game to be modified by states in the United States or countries, based upon the state the player is in, based upon mobile phone or other geolocation identification means. State based integration can be integrated into the embodiments in a variety of manners.

Game Configurator allow for configuration of customer operators to have the opportunity to apply various chosen or newly created business rules on the game as well as to parametrize risk management. Game configurator can be integrated into the embodiments in a variety of manners.

“Fantasy sports connector” are software connectors between method steps or system elements in the embodiments that can integrate fantasy sports. Fantasy sports allow a competition in which participants select imaginary teams from among the players in a league and score points according to the actual performance of their players. For example, if a player in a fantasy sports is playing at a given real time sports, odds could be changed in the real time sports for that player.

Software as a service (or SaaS) is a method of software delivery and licensing in which software is accessed online via a subscription, rather than bought and installed on individual computers. Software as a service can be integrated into the embodiments in a variety of manners.

Synchronization of screens means synchronizing bets and results between devices, such as TV and mobile, PC and wearables. Synchronization of screens can be integrated into the embodiments in a variety of manners.

Automatic content recognition (ACR) is an identification technology to recognize content played on a media device or present in a media file. Devices containing ACR support enable users to quickly obtain additional information about the content they see without any user-based input or search efforts. To start the recognition, a short media clip (audio, video, or both) is selected. This clip could be selected from within a media file or recorded by a device. Through algorithms such as fingerprinting, information from the actual perceptual content is taken and compared to a database of reference fingerprints, each reference fingerprint corresponding to a known recorded work. A database may contain metadata about the work and associated information, including complementary media. If the fingerprint of the media clip is matched, the identification software returns the corresponding metadata to the client application. For example, during an in-play sports game a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet” which is a computer-generated data point is placed above the player that is bet on. Augmented reality can be integrated into the embodiments in a variety of manners.

A betting exchange system is a platform that matches up users who wish to take opposite sides in a bet. Users may “back” or “lay” wagers on the outcome of a sporting event or a portion of the event. Each wager on a betting exchange involves two bets, one backing, and one laying. Back betting, or “backing” a selection, is to wager that the outcome will occur. Lay betting, or “laying” a selection, is to wager that the outcome will not occur. Users may then trade those positions up until the point that the wagering market closes and the wagers are paid out. The value of a wager may increase or decrease based as a sporting event progresses. Exchanges allow users to cash out of their position before the market for a wager closes by selling that wager at the current price to another user on the exchange.

Betting exchange systems allow users to wager on what is not going to happen with “lay” wagers. More often than not, users are more likely to win money by betting on what's not going to happen. Take the correct score markets in soccer, for example. Picking the exact score in a game is impossible to do consistently. One might get it right now and then, but it just comes down to luck. There are so many possible options to choose from. There are nine potential score outcomes even if we could rule out either team scoring more than two goals.

Betting exchange systems may allow wagers involving more than two users as exchange betting allows for one lay bet to be backed by multiple users, each backing a portion of the lay bet. Those wagers may be at different odds. For example, a first user may want to back Team A to win for $20. There may be a second user, or users, who want to lay $10 on Team A not to win at 2 to 1 odds. There may also be a third user, or users, who want to lay $10 on Team A not to win at 3 to 1 odds. The first user may back team A to win for $10 at the best available odds, in this case, 2 to 1. If the first user wants to back team A to win for $20, they will need to back ten dollars at 2 to 1 against the second user and back the other ten dollars against the third user at 3 to 1. This combination of wagers is the equivalent backing Team A to win for $20 at 2.5 to 1 odds.

Betting exchange systems do not take on the risk of any given wager as a traditional sportsbook would as the exchange users set the odds. Removing the risk to the wagering platform allows users to get more value out of a wager as they are paying less to the exchange that does not have to take on the risk that a sportsbook must price into each wager. There is no inherent limit to the stakes or odds that a user of a betting exchange can propose. Betting exchange systems derive revenue from wagers differently than traditional sportsbooks. Revenue is based on the volume of wagers and trades on their platform, removing the results of the wager immaterial to the betting exchange system operation. Betting exchange systems do not lay bets themselves but instead rely on users to offer up their wagers, and the betting exchange system's role is to facilitate the exchange of wager terms, trades of wagers, and settlement of wagers.

Betting exchange systems do not tend to limit or ban successful users the way traditional sportsbooks do. Betting exchange systems do not limit or ban successful users because there is no impact to the betting exchange system from a user's success. A successful user needs only to find someone to take the other side of their wager. A betting exchange system benefits from the increased liquidity brought to markets by successful gamblers.

Betting exchange systems are not limited in the wagers they can offer. A traditional sportsbook will only offer wagers on which they have calculated odds to offer. Users of a betting exchange system may create their own markets for any outcome and odds that have at least one user to back and at least one user to lay a given outcome. Users may also be able to wager at a different price than the market price. For example, if a user is confident the price on a team they want to back is going to drift to a bigger price due to team news, they can put a request up and set a higher price than is currently available, and another user may think they are wrong about their estimation and be prepared to match their bet at the bigger price.

Betting exchange systems may present information related to the exchange and potential wagers to back or lay in several different ways. Some betting exchange systems use a standard or grid interface that puts the back and lay options laid out left to right, with the prices getting higher as you move away from the center. The amount of money or action at a given back or lay price is often displayed. Some betting exchange systems offer an option to back all or lay all. This option allows a user to back or lay an outcome at multiple different prices. A user may not need to back all or lay all to wager at multiple prices on a given outcome.

A “ladder” interface is a view in which that the full market depth of a market on a betting exchange system is shown, along with all the values associated with that price (volume already traded, amounts available, etc.). This type of interface enables a user to see where the market has been and helps them evaluate where it might be heading in the short term. Users may define a default “stake” or wager amount that, once defined, will allow the user to place orders immediately with a single click on the back or lay option at the price the user wants to enter the market at. Users may remove their stake in the same fashion if another user has not yet accepted the stake. Ladder interfaces allow users to place a large number of trades in a short time. This trading volume allows users to win, not only if their selection is successful but by hedging their position across all possible outcomes. Each tick (price increment) on the ladder would display to the user their financial position if they closed at this point. Some betting exchange systems show a graphical representation of where the selection has been matched. Some show the user where they are in the queue of contracts to be met. Third-party software providers receive data from the betting exchange system through an API to allow users to customize their interface and functionality. These third-party software programs may also allow users to incorporate additional data feeds, such as a news feed related to the live sporting event, into the user's wagering interface.

A betting exchange system offers users multiple ways to win. Users may be able to use automated bots to manage their betting activity. Users who lack the expertise to create bots may set up betting triggers that automate certain betting behaviors when specific market prices are met. Users may engage in “position trading” in which bets may be placed with the intent to sell them off, seeking to find opportunities in market swings. Betting exchanges allow users many “hedging” options that may incorporate one or more of these strategies to mitigate risk. Liquidity in betting exchange systems may be limited by regulations that restrict participants in an exchange bet. Therefore, a betting exchange system should take steps to maximize the amount of liquidity on their platform to ensure the most markets are available.

A betting exchange system relies on liquidity to ensure market availability. Markets will only be available if there is someone to both back and lay that market. There will be fewer markets available on a betting exchange if fewer people offer odds, and fewer people offer odds if fewer people accept them. If the people are not offering odds and there is no traditional bookmaker to do it, their markets cannot be created, and wagers cannot be placed.

A machine learning betting system is a system that incorporates machine learning into at least one step in the odds makings, market creation, user interface, or personalization of a sports wagering platform. Machine learning leverages artificial intelligence to allow a computer algorithm to improve itself automatically over time without being explicitly programmed. Machine learning and AI are often discussed together, and the terms are sometimes used interchangeably, but they don't mean the same thing. An important distinction is that although all machine learning is AI, not all AI is machine learning. Machine learning algorithms can develop their framework for analyzing a data set through experience in using that data. Machine learning helps create models that can process and analyze large amounts of complex data to deliver accurate results. Machine learning uses models or mathematical representations of real-world processes. It achieves this through examining features, measurable properties, and parameters of a data set. It may utilize a feature vector, or a set of multiple numeric features, as a training input for prediction purposes. An algorithm takes a set of data known as “training data” as input. The learning algorithm finds patterns in the input data and trains the model for expected results (target). The output of the training process is the machine learning model. A model may then make a prediction when fed input data. The value that the machine learning model has to predict is called the target or label. When excessively large amounts of data are fed to a machine learning algorithm, it may experience overfitting, a situation in which the algorithm learns from noise and inaccurate data entries. Overfitting may result in data being labeled incorrectly or in predictions being inaccurate. An algorithm may experience underfitting when it fails to decipher the underlying trend in the input data set as it does not fit the data well enough.

A machine learning betting system will measure error once the model is trained. New data will be fed to the model, and the outcome will be checked and categorized into one of four types of results: true positive, true negative false positive, and false negative. A true positive result is when the model predicts a condition when the condition is present. A true negative result is when the model does not predict a condition when it is absent. A false-positive result is when the model predicts a condition when it is absent. A false negative is when the model does not predict a condition when it is absent. The sum of false positives and false negatives is the total error in the model. While an algorithm or hypothesis can fit well to a training set, it might fail when applied to another data set outside the training set. It must therefore be determined if the algorithm is fit for new data. Testing it with a set of new data is the way to judge this. Generalization refers to how well the model predicts outcomes for a new set of data. Noise must also be managed and data parameters tested. A machine learning betting system may go through several cycles of training, validation, and testing until the error in the model is brought within an acceptable range.

A machine learning betting system may use one or more types of machine learning. Supervised machine learning algorithms can use data that has already been analyzed, by a person or another algorithm, to classify new data. Analyzing a known training dataset allows a supervised machine learning algorithm to produce an inferred function to predict output values in the new data. As input data is fed into the model, it changes the weighting of characteristics until the model is fitted appropriately. This supervised learning is part of a process to ensure that the model avoids overfitting or underfitting called cross-validation. Supervised learning helps organizations solve various real-world problems at scale, such as classifying spam in a separate email folder.

Supervised machine learning algorithms are adept at dividing data into two categories, or binary classification, choosing between more than two types of answers, or multi-class classification, predicting continuous values, or regression modeling, or combining the predictions of multiple machine learning models to produce an accurate prediction, also known as ensembling. Some methods used in supervised learning include neural networks, naïve Bayes, linear regression, logistic regression, random forest, support vector machine (SVM), and more. A supervised machine learning betting system may be provided a dataset of historical sporting events, the odds of various outcomes of those sporting events, and the action waged on those outcomes, and use that data to predict the action on future outcomes by identifying similar historical outcomes. A machine learning betting system may utilize recommendation algorithms to learn user preferences are for teams, players, sports, wagers, etc.

Unsupervised machine learning analyzes and clusters data that has not been analyzed yet to discover hidden patterns or groupings within the data without the need for a human to define what the patterns or groupings should look like. The ability of unsupervised machine learning algorithms to discover similarities and differences in information makes it the ideal solution for exploratory data analysis, cross-selling strategies, customer segmentation, image, and pattern recognition. Most types of deep learning, including neural networks, are unsupervised algorithms.

Unsupervised machine learning may be utilized in dimensionality reduction or the process of reducing the number of random variables under consideration by identifying a set of principal variables. Unsupervised machine learning may split datasets into groups based on similarity, also known as clustering. It may also engage in anomaly detection by identifying unusual data points in a data set. It may also identify items in a data set that frequently occur together, also known as association mining. Principal component analysis and singular value decomposition are two methods of dimensionality reduction that may be employed. Other algorithms used in unsupervised learning include neural networks, k-means clustering, probabilistic clustering methods, and more.

A machine learning betting system may fall between a supervised machine learning algorithm and an unsupervised one. In these systems, an algorithm used training on a smaller labeled dataset to identify features and classify a larger, unlabeled dataset. These types of algorithms perform better when provided with labeled data sets. However, labeling can be time-consuming and expensive, which is where unsupervised learning can provide efficiency benefits. For example, a sportsbook may identify a cohort of users in a dataset who exhibit desirable behavior. A semi-supervised machine learning betting system may use that to identify other users in the cohort who are desirable.

Reinforcement learning is when data scientists teach a machine learning algorithm to complete a multi-step process with clearly defined rules. The algorithm is programmed to complete a task and is given positive and negative feedback or cues as it works out how to complete the task it has been given. The prescribed set of rules for accomplishing a distinct goal will allow the algorithm will learn and decide which steps to take along the way. This combination of rules along with positive and negative feedback would allow a reinforcement learning machine learning betting system to optimize the task over time. A machine learning betting system may utilize reinforcement learning to identify potential cheaters by recognizing a series of behaviors associated with undesirable player conduct, cheating, or fraud.

Some embodiments of this disclosure, illustrating all its features, will now be discussed in detail. It can be understood that the embodiments are intended to be open ended in that an item or items used in the embodiments is not meant to be an exhaustive listing of such item or items, or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

### EMBODIMENT 1A

### Wager Odds on Player Sensor Data

The embodiments are generally related to wagers in sports or athletics that are focused on player's sensor data.

The embodiments relate to methods, systems, and apparatuses for collecting data and utilizing it in a wagering game. One embodiment includes a system for live sporting event wagering that can have a plurality of sensors, a platform, and a user device, where the plurality of sensors capture sensor data from a live event, the platform receives and stores the captured data from the plurality of sensors data, filters a historical database containing data related to similar situations in the live event, and determines a most likely outcome associated with each player's sensor data, and the probability of the most likely outcome is sent to the user device to receive a wager.

Another exemplary embodiment can describe a method for adjusting odds for wagers in a real time live event wagering game that includes associating one or more sensors with at least one of a player and an object used in a live event that is subject to real time wagering; collecting data from the one or more sensors; transmitting the data from the one or more sensors to a platform; determining odds on one or more real time wagers in the live event based on a comparison of data in a historical database; adjusting the odds based upon the collected data from the one or more sensors; and outputting a wager with the adjusted odds to the live event wagering game.

Another exemplary embodiment includes a computer implemented method for providing a game program using game information, including executing on a processor the steps of displaying a wagering platform; displaying one or more live events on which wagers may be placed; displaying indicia that indicates sensor data is captured in the one or more live events; displaying one or more real time wagers for a live event; displaying information about a play in the live event; and displaying results of a wager from the one or more real time wagers.

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

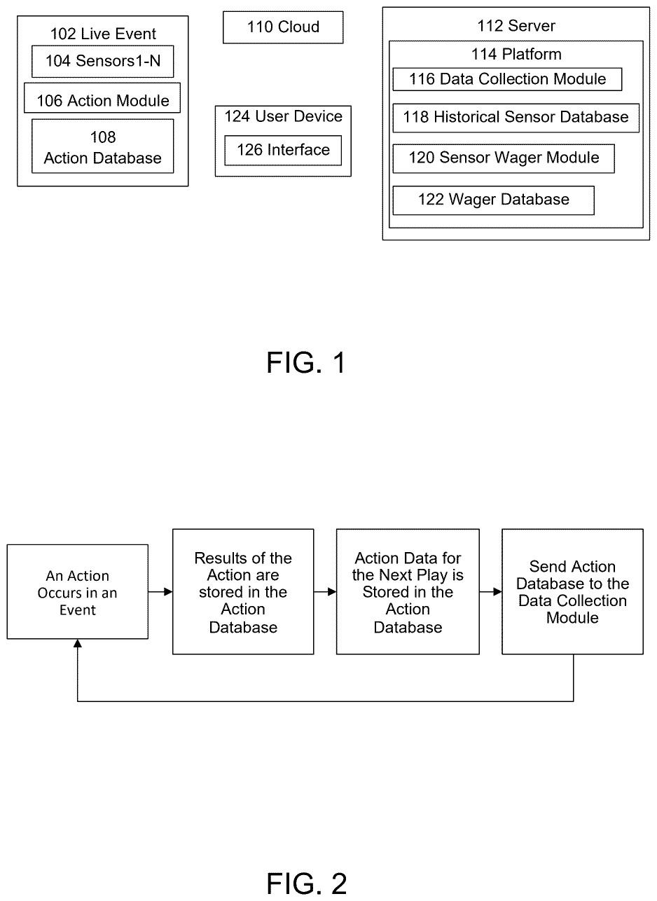

FIG. 1 illustrates methods and systems for sensor wagers, according to an embodiment.

FIG. 2 illustrates an action module, according to an embodiment.

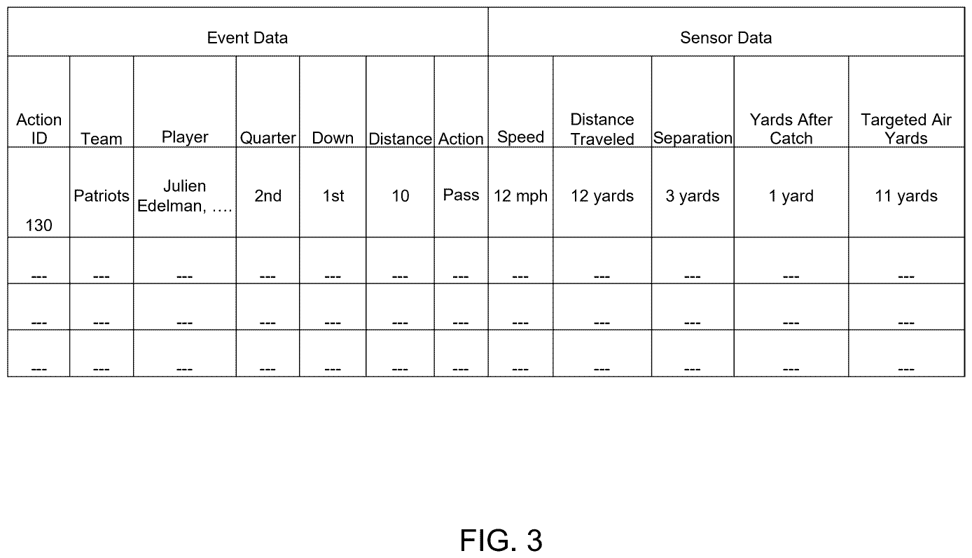

FIG. 3 illustrates an action database, according to an embodiment.

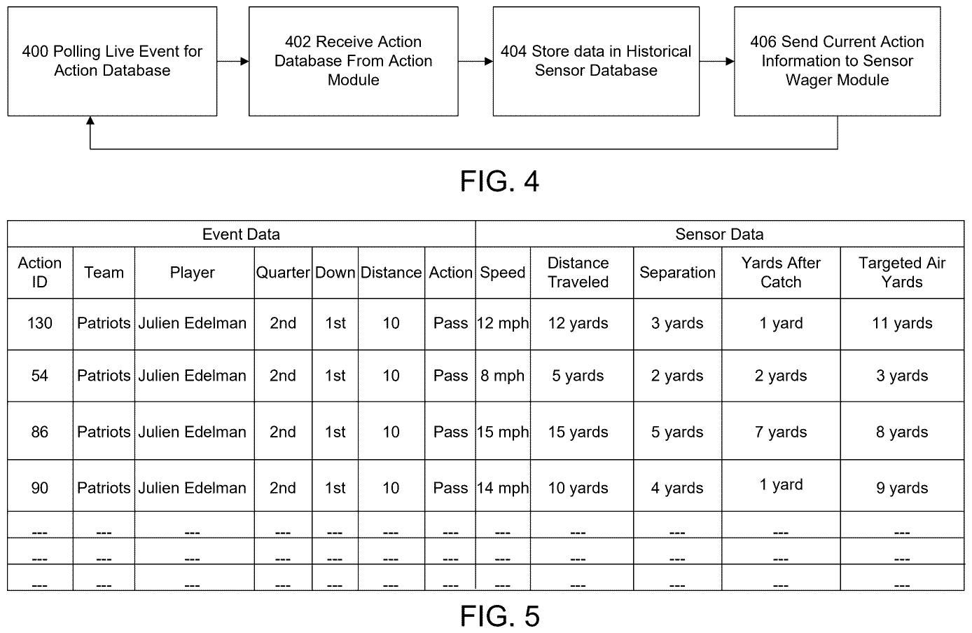

FIG. 4 illustrates a data collection module, according to an embodiment.

FIG. 5 illustrates a historical sensor database, according to an embodiment.

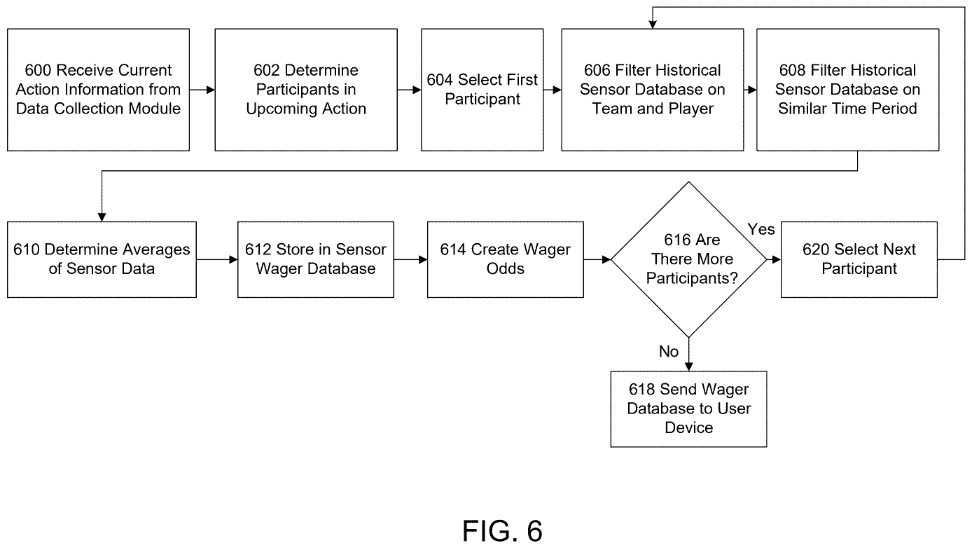

FIG. 6 illustrates a sensor wager module, according to an embodiment.

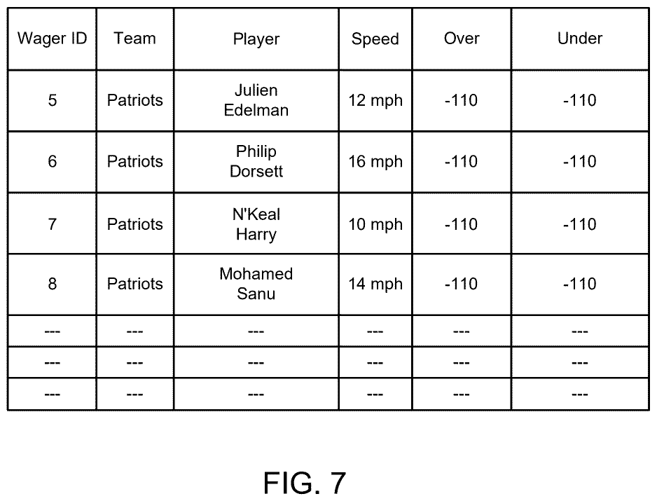

FIG. 7 illustrates a wager database, according to an embodiment.

Generally provided are methods and systems for sensor wagers. This system includes of live event 102, for example a sporting event such as a football game, basketball game, baseball game, hockey game, tennis match, golf tournament, etc. The live event 102 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 102, such as the score of American football or the run line in baseball, or a series of action in the live event 102. Sportsbooks have an amount of bets they can handle, a limit of wagers they can take on either side of a bet before they will move the line or odds off of the opening line. Additionally, there are circumstances, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event 102 or at another location, element 102. The system may include a plurality of sensors 104 that may be used such as motion sensors, temperature sensors, humidity sensors, cameras such as an RGB-D Camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors 104 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

The system may include an action module 106, which is continuously polling the various sensors available during a live event 102 to determine which sensors are available and collect the sensor data and store the data in the action database, element 108. The system may include an action database 108, which stores the sensor data from the plurality of sensors 104 available during a live event 102, element 108. The system also includes a cloud 110 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance. The cloud may be communicatively coupled to server 112 which may perform real time analysis on the type of play and the result of the play. The cloud 110 may also be synchronized with game situational data, such as the time of the game, the score, location on the field, weather conditions, and the like which may affect the choice of play utilized. For example, in other exemplary embodiments, the cloud 110 may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein, element 110. The system may include a server 112 which may perform real time analysis on the type of play and the result of a play or action. The server 112 (or cloud 110) may also be synchronized with game situational data, such as the time of the game, the score, location on the field, weather conditions, and the like which may affect the choice of play utilized. For example, in other exemplary embodiments, server 112 may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. The server 112 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user.

The system may further include a platform 114 which in some embodiments may be located on a server 112, the cloud 110, or the user device 122. The platform 114 contains the data collection module, the historical sensor database, and the sensor wager module 120, which are used to collect the sensor data from the live event 102 and store the sensor data in the historical sensor database via the data collection module and provide wager odds to the user via sensor wager module 120, element 114. The platform may include a data collection module 116, which is continuously polling the live event 102 for the action database 108 which contains sensor data from the live event 102 in order to update the historical sensor database in real time as well as receive the information on the most current play or action within the event, element 116. The platform may include a historical sensor database 118, which contains the historical sensor data from previous live events or sensor data from plays that have previously occurred in a live event 102, element 118. The platform may also include a sensor wager module 120, which uses the current play information from a live event 102 and the data stored in the historical sensor database to create wagering odds that may be provided to a user, element 120. The platform may also include a wager database 122, which stores the wagers created from the sensor wager module 120 and the sensor wager module 120 provides the wager database to the user device to allow the user to view and place their wagers, element 122. The system may include a user device 124, such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device 124 can leverage the sensors in for purposes such as automatic content recognition, augmented reality or the synchronization of screens between the user device interface and other displays. The user device 124, may include interface(s) 126, which may either accept inputs from users or provide outputs to the users or may perform both the actions. In one case, a user can interact with the interface(s) 126 using one or more user-interactive objects and devices. The user-interactive objects and devices may include user input buttons, switches, knobs, levers, keys, trackballs, touchpads, cameras, microphones, motion sensors, heat sensors, inertial sensors, touch sensors, or a combination of the above. Further, the interface(s) 126 may either be implemented as a Command Line Interface (CLI), a Graphical User Interface (GUI), a voice interface, or a web-based user-interface.

FIG. 2 displays the action module 106. The process begins with an action, for example a play, occurs in an event, such as a sporting event. Play data can be any sensor data that indicates anything about the live game, such as, but no limited to audio of visual data that indicates “actions”, “sides”, “event” data, “total” data, “listed pitchers”, specific players, whistles, fouls, touchdowns, goals, yardage, player error, etc., at step 200. The action module 106 then stores the results of the action in the action database 108, such as events data as score, player, time period etc., at step 202. The action module 106 also stores sensor data in the action database 108 which is information for the upcoming play in an event. For example, sensor data could be yards traveled or speed of an athlete, etc., at step 204. The action module 106 then sends the action database 108 to the data collection module and the process returns to step 200, at step 206. It should be noted that the action module 106 can be made available for access, reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”,

FIG. 3 displays the action database 108. The action database 108 stores the sensor data captured from the plurality of sensors 103 available at a live event 102 through the action module 106. The database may include event data, which is informational data about the action or play that occurred within an event, and sensor data, which is the sensor data collected from the various players or participants involved in the play. The event data may be an action ID or play ID, the team participating in the event, the player, the time period of the action, for example for American football the quarter, down, distance, and the action or play that occurred. The sensor data may be adjusted depending on the event, but for this example of American football the sensor data may be speed which shows the maximum speed, measured in Miles Per Hour (MPH), a player achieves on a given play when carrying the ball on offense (rusher, passer or receiver) or special teams (punt or kick returner). The separation which is the distance (in yards) measured between a WR/TE and the nearest defender at the time of catch or incompletion. The yards after catch which are the yards gained after catch by a receiver. The targeted air yards which is the average passing air yards per target for the receiver, by measuring the yards downfield at the time of all passing attempts that the receiver is the target. This stat indicates how far down the field they are being targeted on average. This sensor data may be collected from various types of sensors that the players wear during an event, or through video images in which the players movements are tracked and recorded and in which data can be extracted such as a player's separation from another player, at step 300.

FIG. 4 displays the data collection module 116. The process begins with the data collection module continuously polling the live event 102 for the action database 108 which contains the recently collected sensor data from a live event 102, at step 400. The data collection module receives the action database 108 from action module 106 at the live event 102. In some embodiments, the data collection module may also receive current play information from the live event 102, participants involved in the previous or upcoming play, coaches involved, etc. In some embodiments, the data collection module may use third party data in order to collect the necessary data as opposed to using data collected directly from a live event 102, at step 402. The data collection module stores the sensor data received from the action database 108 in the historical sensor database which contains all the historical sensor data collected from previous live events, at step 404. Then the data collection module sends the current play information and the sensor wager module 120, at step 406.

FIG. 5 displays the historical sensor database 118. The historical sensor database 118 stores the sensor data captured from various live events through the data collection module. The database may include event data, which is informational data about the action or play that occurred within an event, and sensor data, which is the sensor data collected from the various players or participants involved in the play. The event data may be an action ID or play ID, the team participating in the event, the player, the time period of the action, for example for American football the quarter, down, distance, and the action or play that occurred. The sensor data may be adjusted depending on the event, but for this example of American football the sensor data may be speed which shows the maximum speed, measured in Miles Per Hour (MPH), a player achieves on a given play when carrying the ball on offense (rusher, passer or receiver) or special teams (punt or kick returner). The separation which is the distance (in yards) measured between a WR/TE and the nearest defender at the time of catch or incompletion. The yards after catch which are the yards gained after catch by a receiver. The targeted air yards which is the average passing air yards per target for the receiver, by measuring the yards downfield at the time of all passing attempts that the receiver is the target. This stat indicates how far down the field they are being targeted on average. In this example of the historical sensor database 118, the database is filtered for wide receiver Julien Edelman as explained in the sensor wager module. The historical sensor database 118 is filtered on the team, the player, the quarter, the down, the distance, and the action. This is to ensure that the averages taken from the sensor data collected are all from similar situations to allow for realistic probabilities for the upcoming play and thus provide fair wagering odds. In some embodiments, the sensor data may be analyzed locally on the sensor itself and the data may be sent directly to the historical sensor database 118.

FIG. 6 displays the sensor wager module 120. The process begins with the sensor wager module receives the current action information data, or the information on the upcoming play, from the data collection module, at step 600. Then the sensor wager module determines the participants or the players in the upcoming action or play, at step 602. The sensor wager module selects the first participant for the upcoming play, at step 604. Then the sensor wager module filters the historical sensor database 118 on similar situations, such as filtering on the team and player. In some embodiments, the historical sensor database 118 may also be filtered on similar opposing players, referees, weather conditions, location of the event, time of the event (i.e. night vs. day), field conditions, type of field (i.e. real grass vs. artificial), etc. at step 606. Then the sensor wager module is filtered on the similar times within the event, for example if the upcoming play is in the second quarter of an American football game the historical sensor database 118 would be filtered on plays that occurred in the second quarter of an American football game while incorporating the other discussed filters. In some embodiments, the historical sensor database 118 may also be filtered on similar game situations. For example, in American football if the upcoming play was a first down with 10 yards to gain, the historical sensor database 118 would be filtered on all other plays that occurred on a first down with 10 yards to gain while still incorporating the other discussed filters, at step 608. Then, once all the appropriate filters have been applied, the sensor wager module determines the averages of the available sensor data. For example, in American football a wide receivers average sensor data may be for the player's speed, distance traveled, separation, yards after catch, targeted air yards. These averages would be from similar play situations to the upcoming play in the event, at step 610. The sensor wager module then stores the averages of the sensor data in the sensor wager database, at step 612. The sensor wager module then creates the odds for each of the averages. In this example, the odds created can be for the player's sensor data to be over or under their calculated averages from the historical sensor database 118. Typically for Over/Under wagers the same odds are provided for both sides of the wager. For example, the historical sensor database 118 shows historical sensor data of wide receiver Julien Edelman and in this collection of historical sensor data his average speed is 12.25 mph's, so the over/under would be 12 mph. The wager that would be available for users would be “Will Julien Edelman's speed on the next play be over or under 12 mph?”. The odds for under 12 mph may be −110 and the odds for over 12 mph may be −110, which are typical odds that provide the user with even side while incorporating the “juice”. In some embodiments, these may be adjusted due to weather conditions, injury statuses, opposing players, etc. Also, in some embodiments, the type of wager may be altered such as “Who will run the fastest on the upcoming play?” and using the data in the historical sensor database 118 the players averages from the collected sensor data may be compared in order to provide odds as to who will run the fastest on the upcoming play, at step 614. The sensor wager module then determines if there are more participants in the event that have not been selected, at step 616. If there are no more participants that need to be selected the sensor wager module sends the wager database to the user devices to allow user to place their wagers on the upcoming play within an event, at step 618. If there are more participants to be selected, the next participant is selected and the process returns to step 606, at step 620. Further, it may be appreciated that, when playing a wagering game, users may be provided with one or more indicia that available games for wagering have odds affected or adjusted using captured sensor data, that sensor data is available to view and utilize in such games, or that the availability or use of sensor data can be toggled on or off, or otherwise activated or deactivated for different wagers, games, events, and the like.

FIG. 7 displays the wager database 122. The wager database is created through the process described in the sensor wager module in which the sensor wager module filters the historical sensor database 118 on specific players and previous plays or actions that have sensor from similar plays or actions and then determines the averages of the historical sensor data, which is then used to create an over/under wager and the data is stored in the wager database. In this example, the wager database is set up for wagers on wide receiver's speeds on the New England Patriots. The database contains the wager ID, the team, the player, the speed used for the over/under and the odds if the user selected over or under. The sensor wager module sends the wager database to the user device for the user to select the desired wager. In some embodiments, the wager database may be for a plurality of other positions in American football, such as quarterbacks and throwing distance, defensive players making a tackle, etc. The database can be created for a plurality of sporting events, such as baseball, basketball, hockey, etc. In some embodiments, the database may include odds for comparing players to other players such as wager odds for: who will catch the ball on this play, who will run the fastest on the next play, who will run the farthest on the next play, who will have the fastest pulse on the next play, etc. In some embodiments, the sensor data may be collected from equipment used in the event or worn by participants. In some embodiments, the wagers for the sensor data gathered from the equipment may be, for example, in baseball an over/under wager on how fast the exit velocity will be on the next home run, or which player will have the fastest exit velocity in the game. Another example would be if in cricket the field was split into quadrants and the user can select which quadrant the next six will occur. This may be accomplished by using a virtual grid to determine which quadrant the ball went out of play. In some embodiments, the virtual grid may also be used to track players movements and position. A virtual grid would require image processing that breaks the field of play into predefined sections of a certain size that would allow for a quick analysis to determine how far and how fast a player moved throughout the field of play as well as track their position, at step 700. Other examples of wager data can be a “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-cm” or “middle” or “parlay” or “round robin” or “teaser” or “prop bet” or “first-half-bet” or “half-time-bet” or “futures bet” or “future” or “handle” or “juice” or “vigorish” or “off the board”.

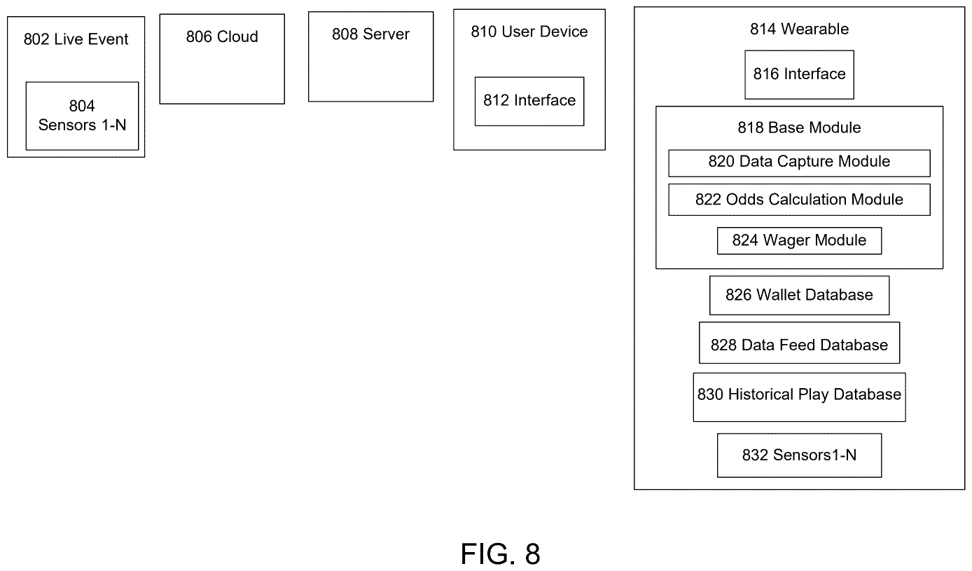

FIG. 8 illustrates a system for play-by-play wager wagering through a wearable device, according to an embodiment.

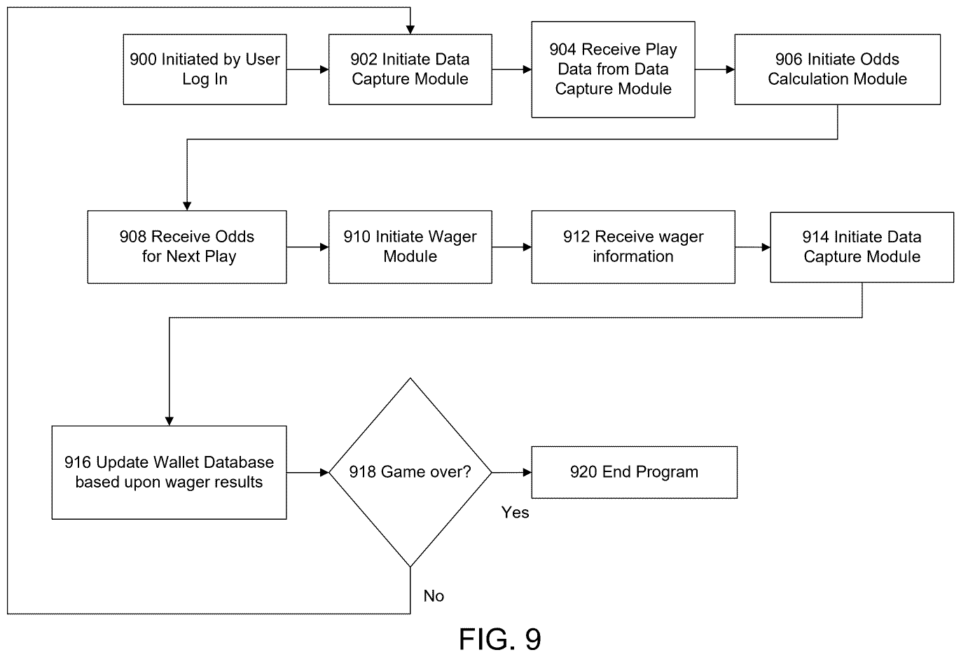

FIG. 9 illustrates a base module, according to an embodiment.

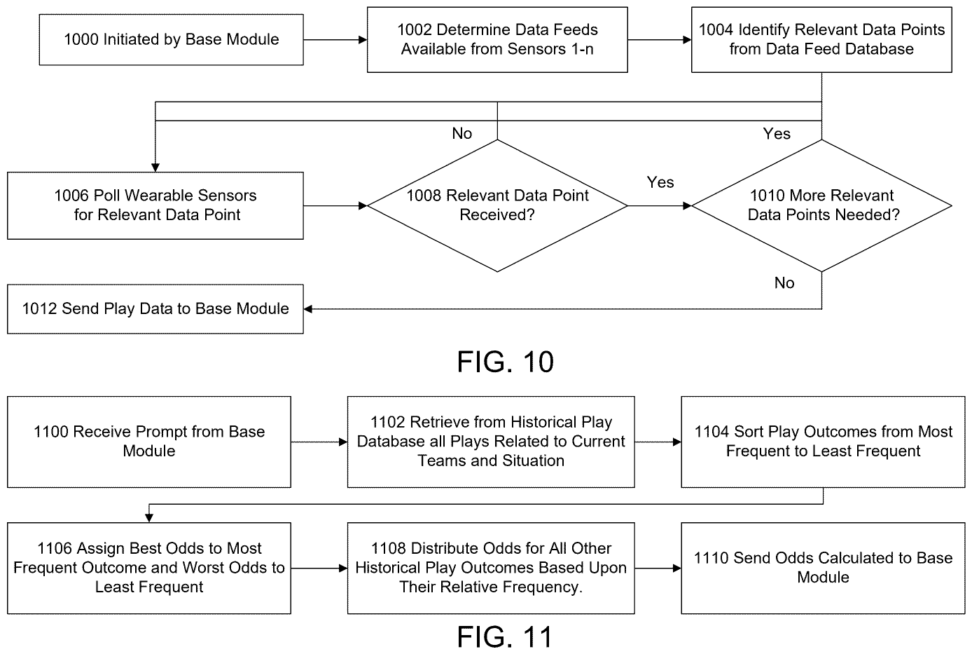

FIG. 10 illustrates a data capture module, according to an embodiment.

FIG. 11 illustrates an odds calculation module, according to an embodiment.

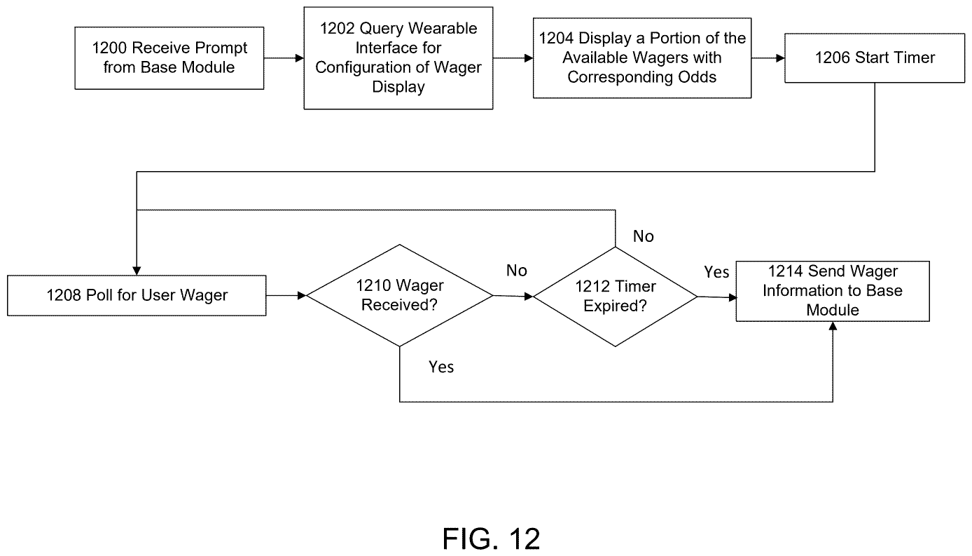

FIG. 12 illustrates a wager module, according to an embodiment.

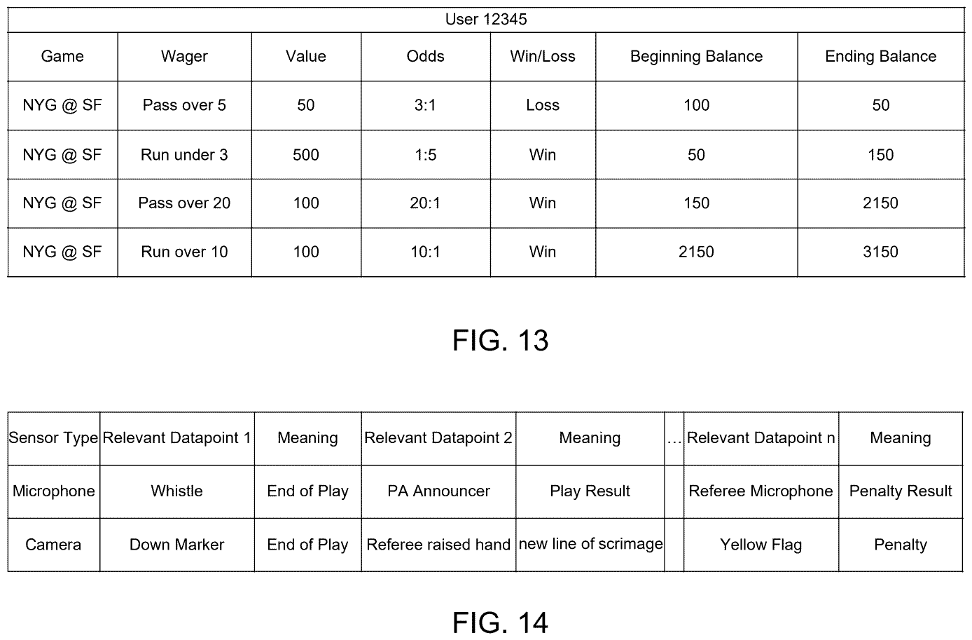

FIG. 13 illustrates a wallet database, according to an embodiment.

FIG. 14 illustrates a data feed database, according to an embodiment.

FIG. 8 displays a system for play-by-play wagering through a wearable device. This system includes of a live event 802, for example a sporting event such as a football game, basketball game, baseball game, hockey game, tennis match, golf tournament, etc., in element 802. The system includes a plurality of sensors 804 that may be used such as motion sensors, temperature sensors, humidity sensors, cameras such as an RGB-D Camera which is a digital camera providing color (RGB) and depth information for every pixel in an image, microphones, radio-frequency receiver, a thermal imager, a radar device, a lidar device, an ultrasound device, a speaker, etc. Also, the plurality of sensors 804 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball, in element 804. The system also includes a cloud 806 or communication network may be a wired and/or a wireless network. A wireless communication network using communication techniques, included by limited to Visible Light Communication (VLC), Worldwide Interoperability for Microwave Access (WiMAX), Long Term Evolution (LTE), Wireless Local Area Network (WLAN), Infrared (IR) communication. The wireless communication network may allow ubiquitous access to shared pools of configurable system resources and higher-level services that can be rapidly provisioned with minimal management effort, often over Internet and relies on sharing of resources to achieve coherence and economics of scale. The wireless communication could also include third-party clouds to enable organizations to focus on their core businesses instead of expending resources on computer infrastructure and maintenance. The cloud 806 may be communicatively coupled to server 808 which may perform real time analysis on the type of play and the result of the play. The cloud 806 may also be synchronized with game situational data, such as the time of the game, the score, location on the field, weather conditions, and the like which may affect the choice of play utilized. In other exemplary embodiments, the cloud 806 may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. The system may include a server 808 which may perform real time analysis on the type of play and the result of a play or action. The server 808 (or cloud 806) may also be synchronized with game situational data, such as the time of the game, the score, location on the field, weather conditions, and the like which may affect the choice of play utilized. For example, in other exemplary embodiments, server 808 may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein, in element 808. A user device such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In this invention the user device could be an optional component and would be utilized in a situation in which the paired wearable device is utilizing the user device as additional memory or computing power or connection to the internet, in element 810. The interface(s) may either accept inputs from users or provide outputs to the users, or may perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a Graphical User Interface (GUI), a voice interface, or a web-based user-interface, in element 812. The wearable device is a category of electronic devices that can be worn on the body as accessories, such as a smart watch or smart glass or a device embedded in clothing or a device implanted in the user's body or a device tattooed on the skin. The devices are hands-free devices with practical uses, powered by microprocessors and enhanced with the ability to send and receive data via the Internet. Some examples of wearable devices include smart watches, and smart glasses, in element 814. The interface(s) may either accept inputs from users or provide outputs to the users, or may perform both the actions. In one case, a user can interact with the interface(s) using one or more user-interactive objects and devices. Examples include the touch screen on a smart watch or the near eye display on smart glasses, in element 816. The base module 818 allows the user to log into the system, prompts the data capture module to determine game and play information, prompts the odds calculation module to calculate the odds of various play results based on the context of the situation determined by the data capture module, prompts the wager module to collect the user's wager, and prompts the data capture module again to collect play results that are then compared to the wager and the wallet database 826 is updated based on the outcome of the wager, in element 818. The data capture module determines which sensors are available on the wearable device, such as a microphone or video feed, determines what relevant data points can be captured by the available sensor(s), monitors for those data points and returns play results based upon the collected data, in element 820. The odds calculation module calculates the odds of each potential play outcome based upon the historical play data related to the teams involved and the context of the game, in element 822. The wager module presents available wagers to the user through the wearable interface, polls for the user's selected wager and returns that selection to the base module 818, in element 824. The wallet database 826 tracks the balance of dollars or points the user has in their account, and updates that balance after the result of each wager, in element 826. The data feed database 828 contains all sensor types the system can utilize from a wearable device, in this example a microphone or video feed, and what relevant data points can be captured by each sensor type so as to determine information about the game being viewed, in element 828. The historical play database, in this embodiment is located on the wearable device, but based upon storage space, processing power and available bandwidth, can be located on the user device or the cloud server. The database contains the historical play data for the relevant sport, in element 830. The sensors 1-n are those sensors in the wearable device that can be used to collect information on the game that can be used to determine the play results and context, in element 832.

FIG. 9 displays the base module 818. The base module 818 begins with the user logging into the system, typically via an app on their wearable device, at step 900. In some embodiments the base module 818 can be located on the user's mobile device and the data capture and wager interaction is done on a paired wearable device, such as smart glasses, or a smart watch. The base module 818 first initiates the data capture module, to determine which game the user is at, and then to monitor for relevant data points to identify the action in the game at step 902. Play data is then returned from the data capture module. Play data can be any sensor data that indicates anything about the live game, such as, but not limited to audio or visual data that indicates “actions”, “sides”, “event” data, “total” data, “listed pitchers”, specific players, whistles, fouls, touchdowns, goals, yardage, player error, etc., at step 904. The base module 818 then initiates the odds calculation module to calculate the odds on the next play, at step 906. The odds for potential outcomes of the next play are retuned by the odds calculation module, at step 908. The base module 818 then initiates the wager module, to present available wagers to the user and collect data on any wagers they select, at step 910. Wager selection information is then returned by the wager module. Wager selection information can be a “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “Handle” or “juice” or “vigorish” or “off the board”, at step 912. The base module 818 then initiates the data capture module again to get play result information to compare to the wager selection returned by the wager module, at step 914. The play result information is received from the data capture module, and the information in the wallet database 826 is updated based on the outcome of the wager, at step 916. The module then determines if the game is over based upon the previous play results, at step 918. If the game is not over, return to step 902. If the game is over, end program. It should be noted that the base module 818 can be made available for access, reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”, at step 920.

Functioning of the data capture module will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 11 shows the odds calculation module 822. The process begins with a prompt from the base module 818 at step 1100. The odds calculation module 822 will then retrieve from the historical play database all historical play data related to the teams in the current game, at step 1102. The odds calculation module 822 then filters the retrieved plays based on the current context, such as which side is on offense, the current score, down and distance, weather, etc. The remaining plays are then sorted based on their frequency in the current context, at step 1104. In one example criteria for this invention is for sorting and filtering plays specific to American football. These example criteria would be specific to the sport in question. The odds are assigned to the filtered play results based upon their historical frequency, or one of the other means of assigning odds that are well known in the art. The best odds are assigned to the most frequent outcome, and the longest odds are assigned to the least frequent outcome, at step 1106. The odds for the plays between the most frequent and least frequent are assigned across the play distribution between the best and longest odds, at step 408. The calculated odds are then sent to the base module 818 at step 1110.

FIG. 12 shows the wager module 824. The process begins with a prompt from the base module 818 at step 1200. The wager module 824 then queries the wearable device interface for configuration information, at step 1202. The configuration information received from the wearable device interface will determine how many wagers can be presented to the user, and the format in which they should be presented. The wager module 824 then displays a portion of the available wagers, in this embodiment the wagers with the best odds are displayed, at step 1204. In other embodiments the wagers displayed could be based upon other factors, such as user history or preferences. The wager module 824 then begins a timer, at step 1206. The timer would be customized based on the pace of play in a given game or sport. In this embodiment the timer is set to 20 seconds. This is because the sport in the example is American football. With a 40 second play clock, it is a reasonable time to allow the user to consider a wager, but not too long so as to have wagers after the start of the play. Wagers submitted after the start of the play are invalid, but the timer is a method of allowing the software to go back to the data capture module. Once the timer is started, the module polls the wearable device interface for a wager by the user, at step 1208. The wager module 824 then determines if a wager was received, at step 1210. If a wager is received, the module returns that wager information to the base module 818. If no wager has been received, the wager module 824 polls the timer to determine if it has reached the threshold for the sport in question at step 1212. If the timer has not expired, the wager module 824 returns to polling the wearable interface for a wager. Once a wager is received or the timer has reached the predetermined threshold, the wager module 824 returns that information to the base module 818 at step 1214.

FIG. 13 shows the wallet database 826. The database contains the user's balance, in real currency or points, each wager the user makes, the results and the new balance in their account. Each user has their own table in the database. The first column records the game on which the wager was made. The second column records the wager the user made, such as betting that the next play will be a pass play that gains more than 20 yards. The third column records the amount the user wagered on the play. The fourth column records the odds on the wager the user made, such as 2:1. The fifth column records if the user won or lost the bet. The sixth column records the user's account balance before the wager. The seventh column contains the user's account balance after the results of the wager are calculated.

FIG. 14 shows the data feed database 828. The database contains the sensor types that can be used by the system to collect information about a play, such as, when it is complete and the results. The first column describes the sensor type, such as a microphone or a camera. The second column lists the first piece of relevant data that sensor is looking for, such as, the whistle for the microphone. The third column contains the meaning of the relevant data point. For example, the referee's whistle will indicate to the microphone that the play has been completed. This two column pattern of relevant data points and their meanings repeats for all relevant data points that can be collected by each sensor.

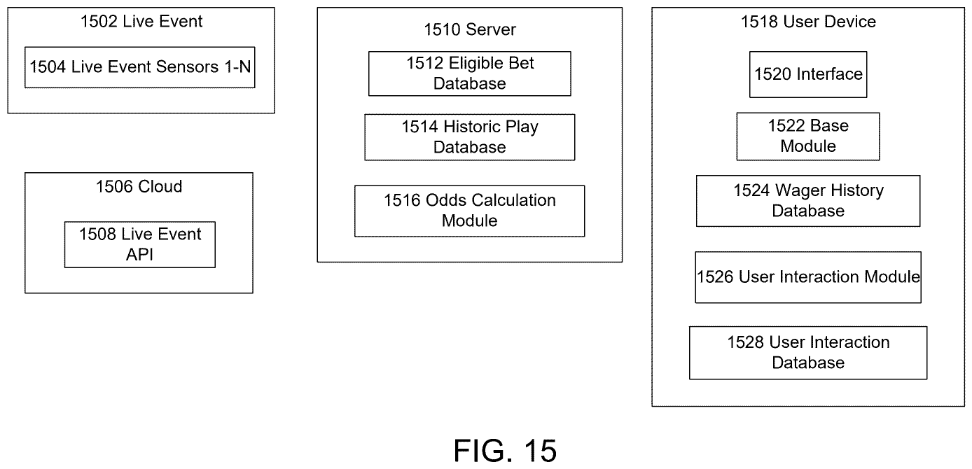

FIG. 15 illustrates a personalized wagering on live events, according to an embodiment.

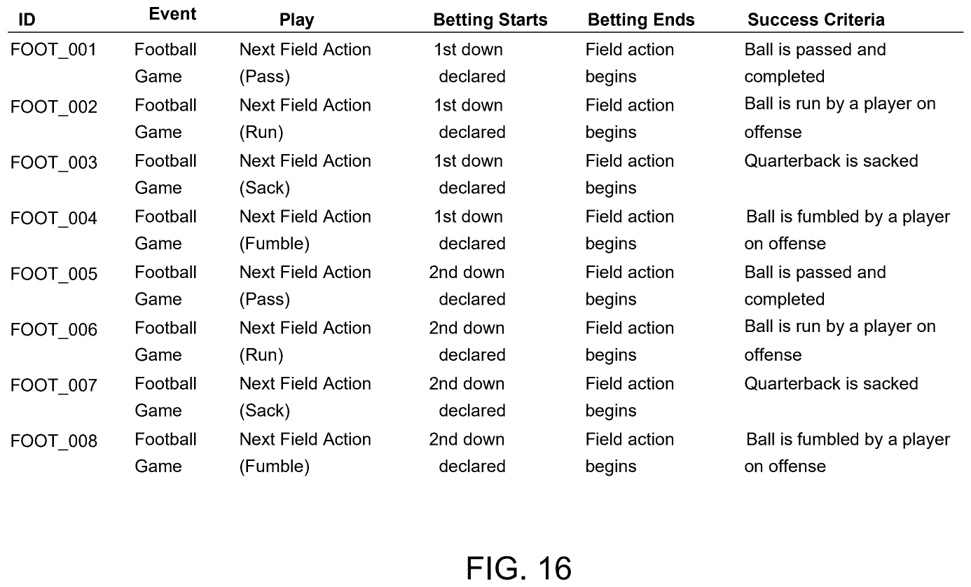

FIG. 16 illustrates an eligible bet database, according to an embodiment.

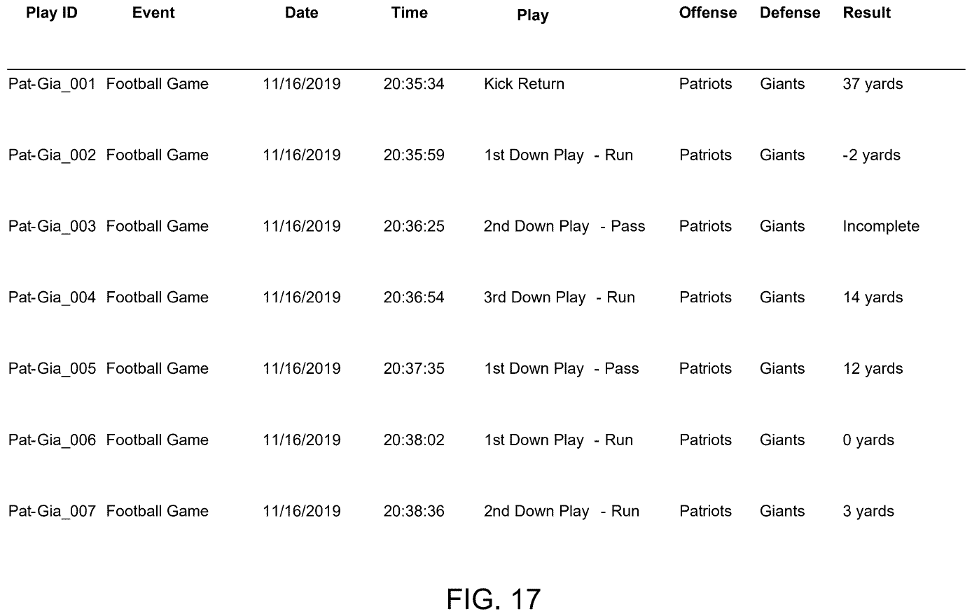

FIG. 17 illustrates a historic play database, according to an embodiment.

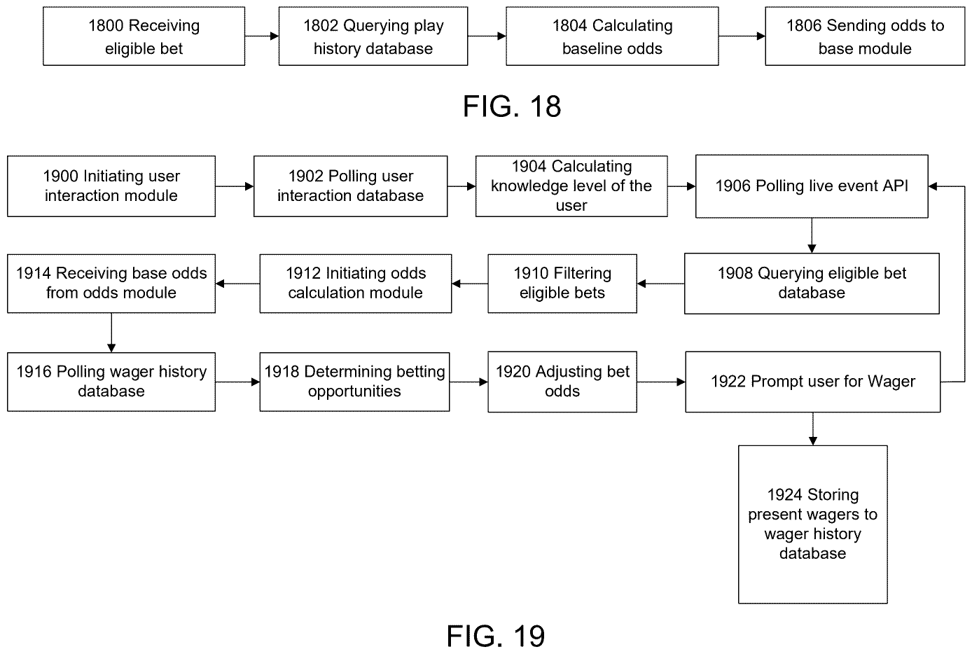

FIG. 18 illustrates an odds calculation module, according to an embodiment.

FIG. 19 illustrates a base module, according to an embodiment.

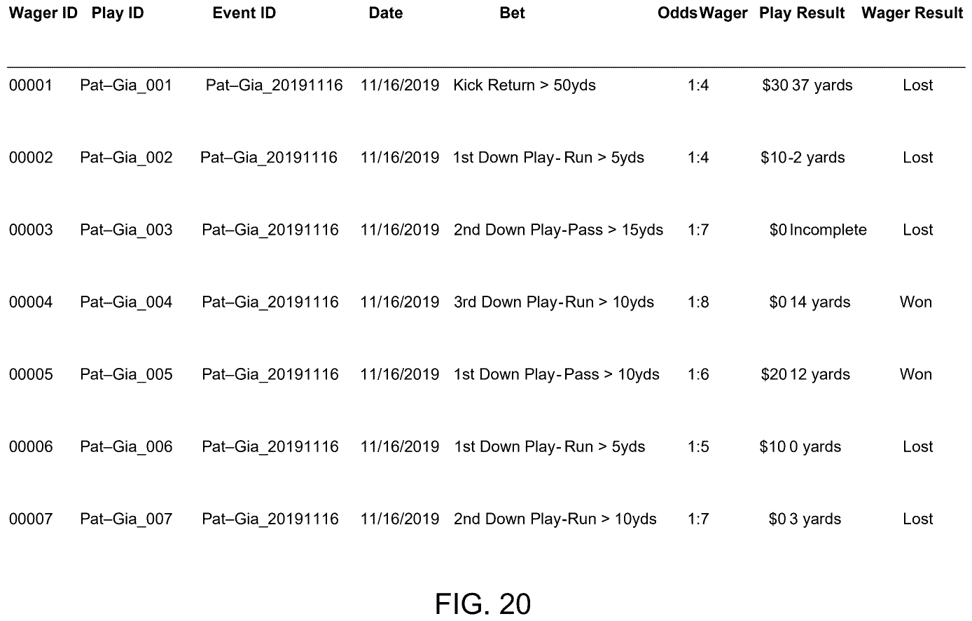

FIG. 20 illustrates a wager history database, according to an embodiment.

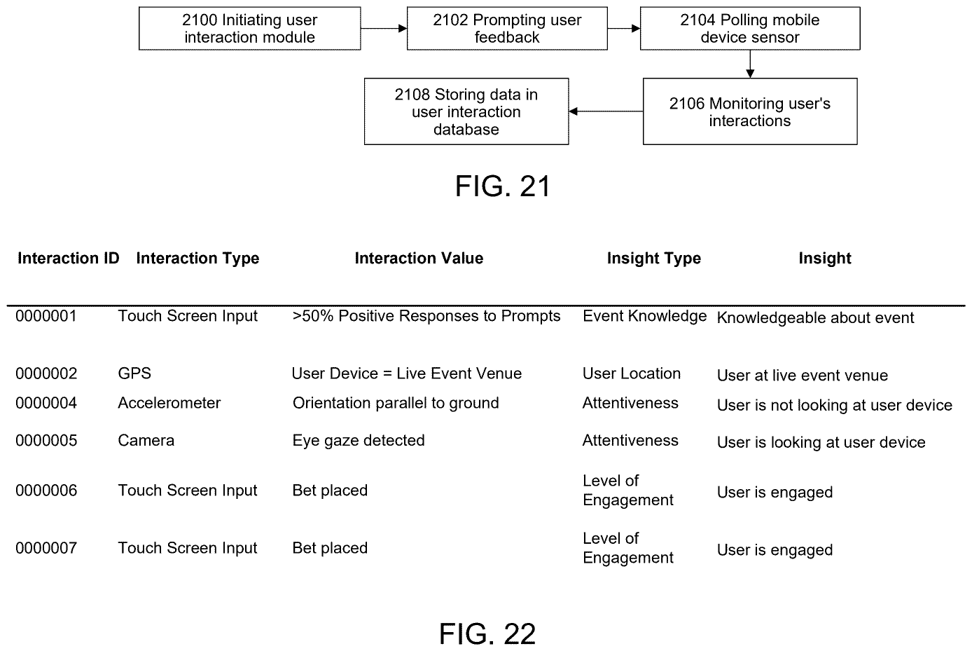

FIG. 21 illustrates a user interaction module, according to an embodiment.

FIG. 22 illustrates a user interaction database, according to an embodiment.

FIG. 15 display a system for a personalized wagering on live events. This system includes a live event 1502, for example a sporting event such as a football game, basketball game, baseball game, hockey game, tennis match, golf tournament, etc. The live event 1502 will include some number of actions or plays, upon which a user or bettor or customer can place a bet or wager, typically through an entity called a sportsbook. There are numerous types of wagers the bettor can make, including, but not limited to a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 1502, such as the score of American football or the run line in baseball, or a series of action in the live event 1502. Sportsbooks have an amount of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event 1502 or at another location, at element 1502.

The system may include a plurality of sensors 1504 that may be used such as motion sensors, temperature sensors, humidity sensors, cameras such as an RGB-D camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors 1504 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball. The system also includes a cloud 1506 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance. The cloud 1506 may be communicatively coupled to server 1510 which may perform real time analysis on the type of play and the result of the play. The cloud 1506 may also be synchronized with game situational data, such as the time of the game, the score, location on the field, weather conditions, and the like which may affect the choice of play utilized. For example, in other exemplary embodiments, the cloud 1506 may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein.

A live event API 1508, or application program interface, for delivering data from the live event 1502 to the server 1510 and user device 1518, at element 1508. The system may include a server 1510 which may perform real time analysis on the type of play and the result of a play or action. The server 1510 (or cloud 1506) may also be synchronized with game situational data, such as the time of the game, the score, location on the field, weather conditions, and the like which may affect the choice of play utilized. For example, in other exemplary embodiments, server 1510 may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein. The server can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user, at element 1510. The eligible bet database 1512 stores criteria for valid bets, such as a play, including when betting begins and closes. Play data can be any sensor data that indicates anything about the live game, such as, but no limited to audio of visual data that indicates “actions”, “sides”, “event” data, “total” data, “listed pitchers”, specific players, whistles, fouls, touchdowns, goals, yardage, player error, etc., at element 1512. A historic play database 1514 which stores all the historic plays of an event, at element 1514. The odds calculation module 1516 uses data from the historic play database 1514 to calculate the probability of an event occurring corresponding with an eligible bet as defined by the eligible bet database 1512, and determining the baseline odds, at element 1516. A user device such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provide for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device 1518 can leverage the sensors in for purposes such as automatic content recognition, augmented reality or the synchronization of screens between the user device interface and other displays, at element 1518. The interface(s) 1520 may either accept inputs from users or provide outputs to the users, or may perform both the actions. In one case, a user can interact with the interface(s) 1520 using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) 1520 may either be implemented as a Command Line Interface (CLI), a Graphical User Interface (GUI), a voice interface, or a web-based user-interface, at element 1520. A base module 1522 receives data from the live event API 1508, the user interaction database 1528, eligible bet database 1512, wager history database 1524, and initiating an odds calculation module 1516, and a user interaction module 1526, to determine betting opportunities and adjusted odds for a specific user, at element 1522. A wager history database 1524 stores all the wagers made by an individual bettor including the odds and the amount wagered. In an embodiment, the wager history database 1524 also storing bets that were presented to the user but for which a wager was not placed by the bettor, at element 1524. A user interaction module 1526 collects user interactions with a user device 1518 and saves the collected data to the user interaction database 1526, at element 1526. A user interaction database 1528 stores user interaction data collected by the user interaction module 1526 including user inputs from buttons, touch screen display, keyboard, camera, accelerometer, or capacitive sensors which may indicate any of the user's knowledge, preferences, attentiveness and level of engagement with the user device 1518, at element 1528. The user device 1518 may include a plurality of mobile device sensors that may be used including any of an accelerometer, tilt sensor, gyroscope, camera, thermometer, hygrometer, photocell, microphone, GPS, bluetooth, Wi-Fi or touchscreen which provide data about the user or the environment proximal the user.

FIG. 16 displays the eligible bet database 1512. The eligible bet database 1512 stores criteria for valid bets, such as they type of event, play, when betting begins and closes, and the criteria which determines whether or not the bet was successful. The eligible bet database 1512 is created by a user who is authorized to create and define betting criteria. In an embodiment, this authorized user is an employee overseeing the operation of the wagering platform. In another embodiment, the authorized user is a user of the wagering platform who manually created a bet, defining the required criteria which is then saved in the eligible bet database 1512. The eligible bet database 1512 is used by the base module 1522 to collect eligible bets which are relevant to an event.

FIG. 17 displays the historic play database 1514. The historic play database 1514 stores data describing each play including the event, time and date, they type of play, who participated in the play such as the team or players on offense or defense, and the result of the play. This data is collected from the live event API and is used by the odds calculation module 1516 to calculate the probability and odds for an eligible bet.

FIG. 18 displays the odds calculation module 1516. The process begins with receiving an eligible bet from the base module 1522 for which to calculate baseline odds. In an embodiment, the eligible bet is whether or not an offensive player in a football game will gain enough yards on the next play to achieve a first down; at step 1800. Querying the play history database 1516 for plays and outcomes related to the eligible bet. In an embodiment, the eligible bet is whether or not an offensive player in a football game will advance the ball enough yards to achieve a first down. The database will be queried for the total number of plays attempted further than 10 yards from the goal line, and the number of those attempts which succeeded in achieving a first down or a touchdown. The data may also include the number of yards required to achieve a first down in each of the play attempts or alternatively the data retrieved may include only the play attempts with a number of yards to first down equaling the total number of yards required for a first down for the current eligible bet. The data may further be refined to include only data pertaining to one or both teams participating in the game and may further specify the players involved, such as the quarterback and players on the defensive line and data relating to their past performances, at step 1802. Determining the historical frequency of plays and outcomes and calculating the odds based on the probability of the play and outcome occurring. In an embodiment, the total number of successful attempts of achieving a first down in a football game is divided by the total number of attempts made to determine a percentile probability of a successful play. Further converting the percentile probability to a fractional probability, rounding to the nearest whole number to convert the probability to the baseline odds (i.e. 0.284=2:7,0.197=1:5), at step 1804. Sending the baseline odds to the base module 1522, at step 1806.

FIG. 19 displays the base module 1522. The process begins when the base module 1522 initiates the user interaction module 1526 to collect user interaction data from the user via the user device 1518. The user interaction module 1526 polling at least one mobile device sensor presenting questions to the user to get user extracted data and determine the user's experience level, and monitoring the user's interactions with the user device 1518 to determine the user's level of attentiveness and level of engagement. Storing the user interaction data in the user interaction database 1528, at step 1900. The base module 1522 polls the user interaction database 1528 for data collected by the user interaction module 1526 to obtain user extracted data. In an embodiment, collecting user interaction data to get the user extracted data includes a user's response to questions or prompts. An example of prompts is the task of identifying several players participating the football game, at step 1902. User extracted data could include user indications of preferences for specific teams and/or players, this may allow the system to show the user more wagers, or targeted wagers, related to those teams and/or players as the user is considered more knowledgeable about their preferred teams and/or players. User extracted data could also include data from the mobile device sensors. This may include geolocation data, which could be used as an indication of increased knowledge of the local team. This may also include engagement tracking metrics, such as eye gaze tracking, that indicate the user's level of engagement with the wagering app, or other related apps such as an analytics service. Long in app times with good engagement metrics may be used to indicate increased knowledge of the user. The base module 1522 calculates a knowledge level of the user by comparing the user's responses to questions or prompts stored in the user interaction database 1528 to the expected responses and calculating the percentage of correct responses. The user extracted data is used for determining the user is knowledgeable about the live event 1502 if the user provides correct answers for at least half of the questions or prompts. In an embodiment, the user is prompted to identify several players who will be participating in the football game that the user intends to place bets on, and upon correctly identifying at least half of the players, is determined to be knowledgeable about the live event 1502, allowing the user to be presented with betting opportunities, such as player specific bets. Alternatively, upon failing to correctly identify at least half of the players as prompted, restricting the user to only team specific betting opportunities and preventing the presentation of player specific bets as the user is determined to lack the knowledge to place bets on player specific bets, at step 1904. The base module 1522 polls live event API 1508 for data from a live event 1502. In an embodiment, the live event 1502 is a football game, and the data collected from the live event API 1508 may include plays, the results of the plays, the players involved in each play, the score and plays resulting in score changes as well as penalties, at step 1906. The base module 1522 queries the eligible bet database 1512 for betting opportunities which may be presented to a user based on data available from the live event API 1508. In an embodiment, the live event 1502 is a football game and a betting opportunity comprising any of the action and outcome of a play including first down, scoring event, whether the ball was run or passed for completion over a minimum or specific number of yards and optionally the player who executed the play. For example, an eligible bet may be whether or not a team will get a first down on the next play, at step 1908. The base module 1522 filters eligible bets from the eligible bet database 1512 which are relevant to the live event 1502. In an embodiment, the user is determined, based on user extracted knowledge, to have a low level of knowledge about the live event 1502, a football game, and therefore any otherwise eligible bets pertaining to specific players are not selected, and only team specific bets are selected, at step 1910. The base module 1522 sends the selected eligible bets to the odds calculation module 1516 to determine the base odds for each selected eligible bet. The odds calculation module 1516 receiving an eligible bet, polling the historic play database 1514 for plays and outcomes related to the bet, determining the frequency of past plays and outcomes, calculating the probability of the play and outcome occurring and converting the probability into a baseline odd, at step 1912. The base module 1522 receives the calculated base odds for each eligible bet from the odds calculation module 1516. The odds being in a fractional format such as 1:5 or 1:7 at step 1914. The base module 1522 polls the wager history database 1524 for past wagers made by the user relevant to the live event 1502. In an embodiment, the live event 1502 is a football game, and past wagers may include bets placed on whether a team would make a first down on a given play or whether the offensive team would score a touchdown on a given play. Further polling the wager history database 1524 for the odds associated with past wagers and determining a pattern of bets made by the user, such as a preference for a particular type of wager, such as betting on scoring plays, or betting on particular odds, such as bet opportunities with odds greater than, for one example, 1:10, at step 1916. The base module 1522 determines which betting opportunities from the selected eligible bets to present to the user. The determination may use any data from the user interaction database 1528 (such as GPS location or engagement level) or the wager history database 1524 (such as patterns of preferred bets or preferred odds) to determine the betting opportunities most likely to be bet on by the user. In an embodiment, three bets are identified to be presented to the user for the next play on 3rd down: run at least 5 yards for first down with 1:7 odds, 37-yard field goal attempt with 1:5 odds, and at least 10 yard pass for first down with for example, 1:6 odds, at step 1918. The base module 1522 adjusts the bet odds using any of, engagement level, GPS location of the user or past wagers by increasing the odds in favor of the user to incentivize the user to make a bet or to reduce the odds for the user for bets the user is likely to make regardless of the odds as to reduce the potential payout. In an embodiment, the user has placed bets on whether a player will score on a play with fewer than, for example, 0 yards to goal, however only does so, for example 25% of the time when the odds are equal to the baseline odds of, for example, 1:5. To incentivize the user to take the bet, the odds are increased in favor of the user to 1:7 to increase the likelihood the user will make a bet, at step 1920. The base module 1522 presents an adjusted bet odd to the user of a user device 1518 and prompting the user to select at least one wager. In an embodiment, the user selecting a bet with adjusted odds of for example, 1:5 that the quarterback of the team on offense will be sacked in the next play and wagerings, for example, $10, at step 1922. The base module 1522 receives a wager from the user via the user device 1518 and storing the wager to the wager history database 1524. It should be noted that the base module 1522 can be made available for access, reconfiguration, modification, or control for “customers” or used for “Managed service user interface service”, “Managed service risk management services”, “Managed service compliance service”, “Managed service pricing and trading service”, “Managed service and technology platform” “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”, at step 524.

FIG. 20 displays the wager history database 1524. The wager history database 1524 stores all the wagers made by an individual user including the odds, the amount wagered and the results of the wager. In an embodiment, the wager history database also stores bets that were presented to the user but for which a wager was not placed by the user. The wager history database 1524 is updated by the base module 1522 when a user submits a wager and is used by the base module 1522 to determine wagering behaviors of the user.

FIG. 21 displays the user interaction module 1526. The process begins with the base module 1522 initiating the user interaction module 1526, at step 2100. The user interaction module 1526 presents a game, quiz or series of questions to the user which can be used to obtain user extracted data to determine the user's level of experience and knowledge of the live event 1502. In an embodiment, the user intends to bet on a football game and may be asked to identify a half dozen players participating in the game. If the user positively matches a majority of the players, then the user is determined to have a high knowledge of the event being bet on and therefore may be presented with additional eligible bets such as those specifying the performance of individual players. If the user does not positively match a majority of the players, the user is determined to have a lower knowledge of the event being bet on and would only be presented with team level betting opportunities, at step 2102. The user interaction module 1526 polls at least one mobile device sensor such as a GPS, camera, accelerometer, tilt sensor or touch screen input. In an embodiment, polling the GPS sensor of the user device 1518 and determining that the location of the user device 1518 is in or near the live event venue. In another embodiment, polling the accelerometer, tilt sensor, or camera to determine whether the user is looking at the user device 1518, or is holding the user device 1518 in an orientation indicating the user is or may be looking at the device, at step 2104. The user interaction module 1526 monitors the user's interactions with the user device 1518. User interactions can include any of providing user inputs via buttons, keyboard, stylus, or a touch screen interface to a prompt, such as question or prompt. User interactions can further include any sensor data such as from a camera, accelerometer or tilt sensor, which can indicate the level of interaction or attentiveness of the user. In an embodiment, the user may be holding the user device 1518 with the screen parallel to the ground, indicating that the user is not looking at or interacting with the device. Alternatively, the user may be scrolling through a list of bets indicating that the user is engaged with the device, at step 2106. The user interaction module 1526 stores the user interaction data in the user interaction database 1528, at step 2108.

FIG. 22 displays the user interaction database 1528. The user interaction database 1528 stores user interaction data collected by the user interaction module 1526 including user inputs from buttons, touch screen display, keyboard, camera, accelerometer, or capacitive sensors which may indicate any of the user's knowledge, preferences, attentiveness and level of engagement with the user device 1518. The data is used by the base module 1522 to determine the level of experience of the user to allow filtering of eligible bets to only present those to the user for which the user has demonstrated knowledge. The data in the User Interaction Database 1528 is further used by the base module 1522 to identify bets to present to the user.

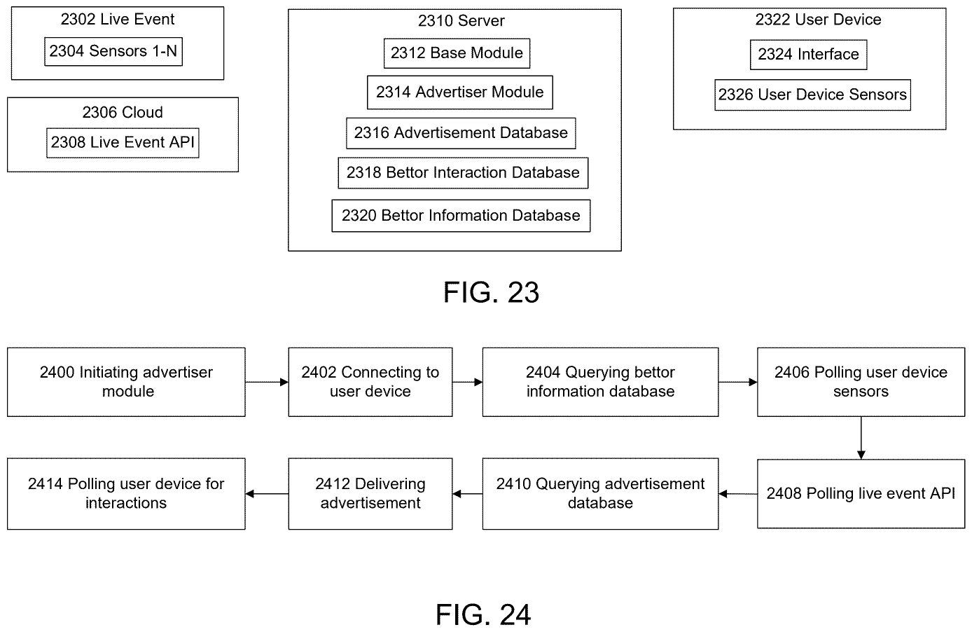

FIG. 23 illustrates an advertising via a live event wagering platform, according to an embodiment.

FIG. 24 illustrates a base module, according to an embodiment.

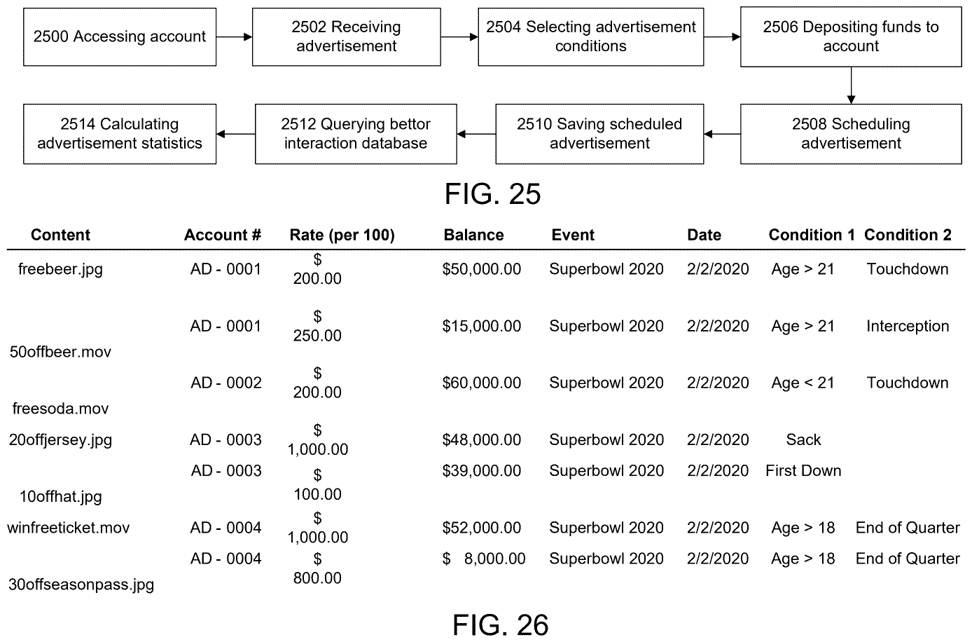

FIG. 25 illustrates an advertiser module, according to an embodiment.

FIG. 26 illustrates an advertisement database, according to an embodiment.

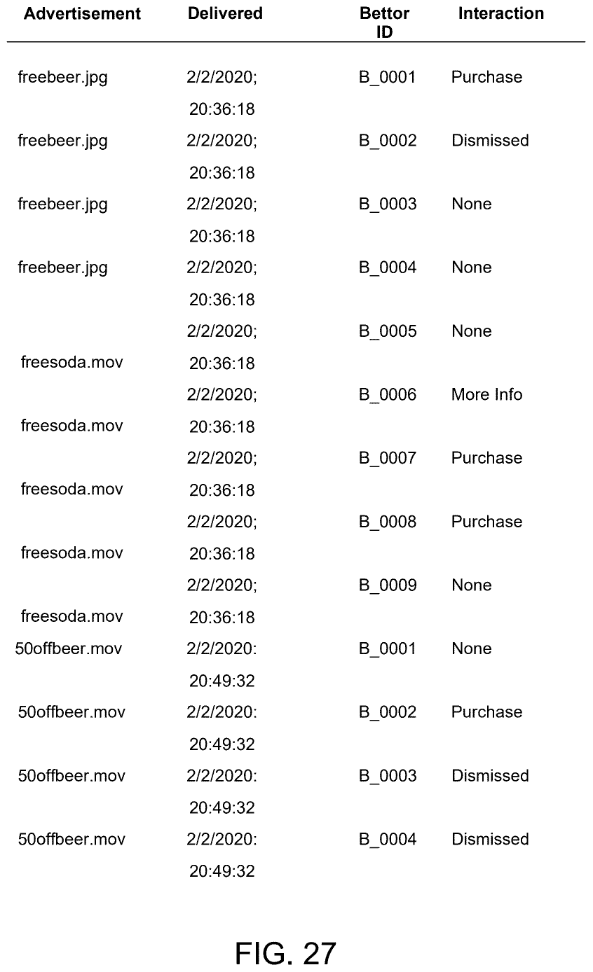

FIG. 27 illustrates a bettor interaction database, according to an embodiment.

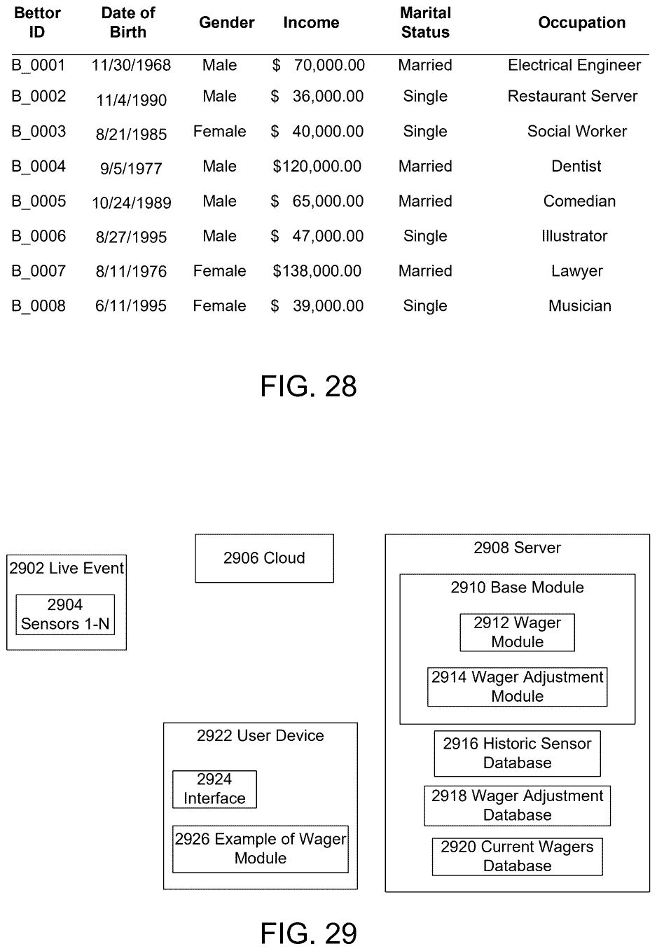

FIG. 28 illustrates a bettor information database, according to an embodiment.

FIG. 23 displays a system for advertising via a live event 2302 wagering platform. This system includes a live event 2302, for example a sporting event such as a football game, basketball game, baseball game, hockey game, tennis match, golf tournament, etc. . . . The system may include a plurality of sensors 2304 that may be used such as motion sensors, temperature sensors, humidity sensors, cameras such as an RGB-D Camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

The system also includes a cloud 2306 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance. The cloud 2306 may be communicatively coupled to server 2310 which may perform real time analysis on the type of play and the result of the play. The cloud 2306 may also be synchronized with game situational data, such as the time of the game, the score, location on the field, weather conditions, and the like which may affect the choice of play utilized. For example, in other exemplary embodiments, the cloud 2306 may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. A live event API 2308, or application program interface, for delivering data from the live event 2302 to the server 2310 and user device 2322. The system may include a server 2310 which may perform real time analysis on the type of play and the result of a play or action. The server 2310 (or cloud 2306) may also be synchronized with game situational data, such as the time of the game, the score, location on the field, weather conditions, and the like which may affect the choice of play utilized. For example, in other exemplary embodiments, server 2310 may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. A base module 2312 which initiates an advertiser module 2314 and accesses a user device 2322, advertisement database 2316 and bettor information database 2320, and monitors a live event API 2308; matching advertisement conditions from the advertisement database 2316, and when the conditions are met, delivering an advertisement via an interface 2324 on a user device 2322. It may be appreciated that the conditions from an advertisement database 2316 may include conditions related to a bettor (such as selected or determined preferences, for example based on betting history), conditions related to live action game (such as a timeout, end of playing period, or other play stoppage), or conditions related to a wager (such as placement of a wager on a time real play in a live action game, a successful wager, a losing wager, a wager placed on a certain type of play or action, a wager placed on a certain team or player, and the like. An advertiser module 2314 receives an advertisement, conditions under which the advertisement is to be delivered, a deposit of funds and scheduling information, and saves the data to an advertisement database 2316. An advertisement database 2316 stores advertisement data including an advertisement, in the form of advertising content such as one or more images, videos, sounds or messages to be delivered. The advertisement database 2316 additionally storing conditions to be met before delivering the advertisement, a deposit of funds, and a schedule of which live events 2302 the advertisement can be delivered during. A bettor interaction database 2318 stores data, logging interactions by a bettor with a user device 2322 or the bettor's surroundings such as requesting additional information about a product featured in an advertisement or dismissing an advertisement. Alternatively, the bettor interaction database 2318 storing information about purchases made by a bettor. The bettor information database 2320 including data pertaining to the bettor including demographics or history data. Bettor demographics data including any of gender, date of birth or age, income, education level, occupation, race or ethnicity, marital status or homeowner status. Bettor history data including any of past bets placed or passed over, bets including at least the event bet upon, success criteria, odds, amount wagered, and the wager outcome, and optionally the live event 2302 and other parties involved (if a multiparty bet). A user device 2322 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The interface(s) 2324 may either accept inputs from users or provide outputs to the users, or may perform both the actions. In one case, a user can interact with the interface(s) 2324 using one or more user-interactive objects and devices. The user-interactive objects and devices may include user input buttons, switches, knobs, levers, keys, trackballs, touchpads, cameras, microphones, motion sensors, heat sensors, inertial sensors, touch sensors, or a combination of the above. Further, the interface(s) 2324 may either be implemented as a Command Line Interface (CLI), a Graphical User Interface (GUI), a voice interface, or a web-based user-interface. The user device 2322 may include a plurality of user device sensors 2326 that may be used including any of an accelerometer, tilt sensor, gyroscope, camera, thermometer, hygrometer, photocell, microphone, GPS, bluetooth, Wi-Fi or touchscreen which provide data about the user or the environment proximal the user.

FIG. 24 displays the base module 2312. The process begins with initiating the advertiser module 2314, including, prompting an advertiser to create or sign into an account, receiving an advertisement from an advertiser, the advertiser selecting conditions wherein the advertisement will be displayed when the conditions are met, depositing funds to an account to be debited when an advertisement is displayed, and receiving from the advertiser one or more dates or events during which to deliver the advertisement. The scheduled advertisement being saved to the advertisement database 2316 and being made available to the base module 2312, at step 2400. Establishing a connection to a user device 2322. In an embodiment, the user device 2322 is a smartphone and the connection is established via a 5G cellular data connection, at step 2402. Querying the bettor information database 2320 for information about the bettor including any of demographics or history data. Demographics data including any of gender, date of birth or age, income, education level, occupation, race or ethnicity, marital status or homeowner status. History data including any of past bets placed or passed over, bets including at least the event bet upon, success criteria, odds, amount wagered, and the wager outcome. Bets data can be any of a selection of “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “Handle” or “juice” or “vigorish” or “off the board”, at step 2404. Polling user device sensors 2326 to determine the location of the user device 2322. The user device sensors 2326 including any of GPS (global positioning system), cellular service, Bluetooth, Wi-Fi, RFID (radio frequency identification) or NFC (near field communications), and determining the location of the user device 2322 using a method including any of proximity sensing, triangulation, or range finding, such that the location of the user can be determined. In an embodiment, a GPS sensor on the user device is used to determine the location of a user as being within a football stadium. In another embodiment, the Bluetooth sensor on the user device 2322 is used to communication with a BLE (Bluetooth Low Energy) beacon to determine the proximity of the user device to the BLE beacon, such as within a particular section of seating within a football stadium, at step 2406. Polling a live event API for data 2308 from a live event 2302. In an embodiment, the live event 2302 is a football game, and the data collected from the live event API 2308 may include plays, the results of the plays, the players involved in each play, the score and plays data resulting in score changes as well as penalties. In an embodiment, the data additionally including environmental events or conditions such as weather, venue, and lighting. Play data can be data that indicates anything about the live game, such as, but not limited to audio of visual data that indicates “actions”, “sides”, “event” data, “total” data, “listed pitchers”, specific players, whistles, fouls, touchdowns, goals, yardage, player error, etc., at step 2408. Querying the advertisement database 2316 for advertisements with delivery conditions matching any of bettor data from the bettor information database 2320, sensor data from a user device 2322, such as location, or data from a live event API 2308, such as plays or environmental conditions. In an embodiment, the bettor is a 34-year-old male, sensor data from a user device 2322 indicates that the bettor is in a football stadium in a section adjacent to a vendor selling beer and data collected from a live event API 2308 indicates that the home team just scored a touchdown. The advertisement database 2316 returning an advertisement for beer being sold at the vendor adjacent to the section in which the bettor is located because the conditions associated with the advertisement are that the advertisement is to be delivered when a touchdown is scored to anyone within two sections of the vendor selling the beer. In another embodiment, selecting an advertisement in response to a successful wager, at step 2410. Delivering an advertisement to the bettor via the interface 2324 on the user device 2322. In an embodiment, the advertisement may include a promotion, such as a voucher for a free or discounted product. Further, the advertisement may include a method of ordering a product being advertised in the advertisement, such as including a link to an order screen, or a ‘one click’ ordering method wherein the bettor's payment information is already stored in the user device 2322 allowing the bettor to place an order with as few as one interaction with the user device 2322. In another embodiment, an advertisement being delivered with a real-time replay of a play, such that the advertisement immediately precedes or follows the replay or is overlaid on top of the replay, at step 2412. Polling a user device 2322 for interactions during and after the delivery of an advertisement and saving the interactions to the bettor interaction database 2318. In an embodiment, the bettor interactions including interactions with the interface 2324 including requesting additional information about the product being advertised or dismissing the advertisement. In another embodiment, the sensors on the user device 2322 indicating that the user device has moved from a viewing location to a vendor location, indicating the purchase of a product. It should be noted that the base module 2312 can be made available for access, reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”, at step 2414.

FIG. 25 displays the advertiser module 2314. The process begins with prompting a user to create or sign into an account to facilitate the management of advertisements to be delivered, at least in part, by a wagering platform. The account allowing the uploading of advertisements, selection of the conditions that, when met, will result in the delivery of the advertisement or promotion. The account further accepting funds intended to be used to purchase advertisements and fund other promotions, at step 2500. Receiving an advertisement to be displayed to a bettor, the advertisement in the format of any of an image, video, animation, recorded or synthesized audio file or text. An advertisement may additionally include a promotion, discount, or complimentary product, service or credit which may be redeemed immediately, at a later date, at the venue, online, in a traditional restaurant, convenience or retail outlet or for delivery or in home services. In an embodiment, the advertisement is a short, 10 second video, offering the bettor a 20% discount on draft beer at the nearest concession's booth at the venue where the live event 2302 is being held which the bettor may redeem before the end of the event, at step 2502. Selecting conditions under which to present the advertisement to a bettor. The conditions including any of bettor demographics or history data or live event data. Bettor demographics data include any of gender, date of birth or age, income, education level, occupation, race or ethnicity, marital status or homeowner status. Bettor history data including any of past bets placed or passed over, bets including at least the event bet upon, success criteria, odds, amount wagered, and the wager outcome, and optionally the live event 2302 and other parties involved (if a multiparty bet). Bettor history data further including interaction and engagement data such as advertisements viewed and the level of attentiveness while advertisements are delivered to the bettor via sensor data including accelerometer or tilt sensor data determining the orientation of the user device or camera data, detecting the bettor's eye gaze, or interaction with the user device input methods such as buttons, touchscreen interface or an integrated or external input device such as a keyboard, mouse, stylus or gesture control interface. Live event data including any of the live event 2302, one or more past, present or anticipated plays, players or participants in the live event 2302 including coaches, scores, penalties or weather conditions including temperature, precipitation, UV index, air quality, humidity, wind speed and direction. In an embodiment, the conditions for the advertisement described in the previous step direct the ad to be delivered to a bettor within one minute of winning a bet on a touchdown with a temperature greater than 50 degrees Fahrenheit, at step 2504. Depositing funds intended to be used to purchase advertisements or other promotions to an account. The funds to be debited from the account as advertisements or other promotions are delivered to bettors. In an embodiment, using the funds to purchase one or more views of an advertisement or the distribution of a promotion, such as a credit for a free beverage at the nearest concession both within the venue, at step 2506. Scheduling at least one advertisement by selecting one or more rates from a rate table and including the maximum number of advertisement deliveries or allotting a balance of funds to be debited from according to the selected rate(s). In an embodiment, presenting a rate table to an advertiser, each rate representing the cost to deliver a unit of advertisements. A unit of advertisements may be the delivery and view of one advertisement or multiple deliveries of the same advertisement. The rate table varying based upon time, event, play and advertisement type. The rate table may further vary based upon advertisement conditions such as the weather during a live event 2302. For example, an advertisement for a beer is scheduled to be delivered up to 1000 times when the home team earns a first down in a Monday night football game when the Patriots are playing at a rate of $20 for every 100 deliveries, and up to 200 times when the Patriots sack their opponent's quarterback at a rate of $30 for every 20 deliveries, at step 2508. Saving the scheduled advertisement to the advertisement database 2316. The advertisement database 2316 storing the advertisement content, the conditions under which to deliver the advertisement content to a bettor, the maximum number of advertisements to be delivered and the rate to be paid in addition to the account from which to debit the funds upon delivery of the advertisement, and the live event 2302 during which to deliver the advertisement, at step 2510. Querying the bettor interaction database 2318 for statistics pertaining to an advertisement. In an embodiment, the query requesting interactions in response to the delivery of an advertisement for a product, such as beer for sale in the venue. The interactions including the bettor purchasing the product before leaving the venue, the bettor requesting additional information about the product via the user device, and the bettor taking no action or dismissing the advertisement, at step 2512. Calculating advertisement statistics from the data retrieved from the bettor interaction database 2318 and displaying the statistics to a user via an interface 2324 on a user device 2322. In an embodiment, dividing the number of advertisement deliveries after which the bettor purchased the product, and divide by the total number of deliveries of the advertisement to determine the conversion rate of the advertisement, and displaying the conversion rate to a user via an interface 2324 on a user device 2322, at step 2514.

FIG. 26 displays the advertisement database 2316. The database including advertisement content such as images, videos, text and audio, scheduling information, such as the live event 2302 during which the advertisement can be delivered, a balance of funds and a rate by which the balance will be debited from the account balance, and at least one condition, which when met, the advertisement will be delivered. The advertisement database 2316 populated by the advertiser module 2314 and used by the base module 2312 to deliver advertisements via an interface 2324 on a user device 2322, in FIG. 2600.

FIG. 27 displays the bettor interaction database 2318. The database including data pertaining to a delivered advertisement including information identifying the advertisement and when it was delivered, to which user device 2322 the advertisement was delivered, and actions taken by a bettor following the delivery of the advertisement. The bettor interaction database 2318 being populated by the base module 2312 and used by the advertiser module 2314 to calculate statistics relating to the advertisements, in FIG. 2700.

FIG. 28 displays the bettor information database 2320. The database stores data about the bettor including demographics or history data. Bettor demographics data including any of gender, date of birth or age, income, education level, occupation, race or ethnicity, marital status or homeowner status. Bettor history data includes any of past bets placed or passed over, bets including at least the event bet upon, success criteria, odds, amount wagered, and the wager outcome, and optionally the live event 2302 and other parties involved (if a multiparty bet). The bettor information database 2320 is populated with data provided by the bettor and is used by the base module 2312 to determine which advertisements to present to the bettor, in FIG. 2800.

FIG. 29 illustrates a system using sensors to improve odds, according to an embodiment.

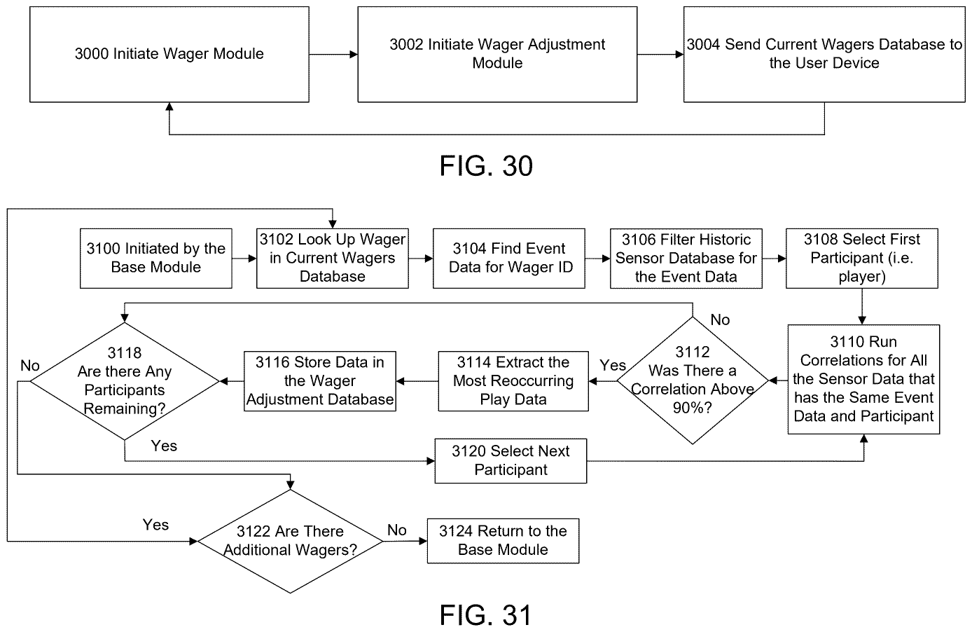

FIG. 30 illustrates a base module, according to an embodiment.

FIG. 31 illustrates a wager module, according to an embodiment.

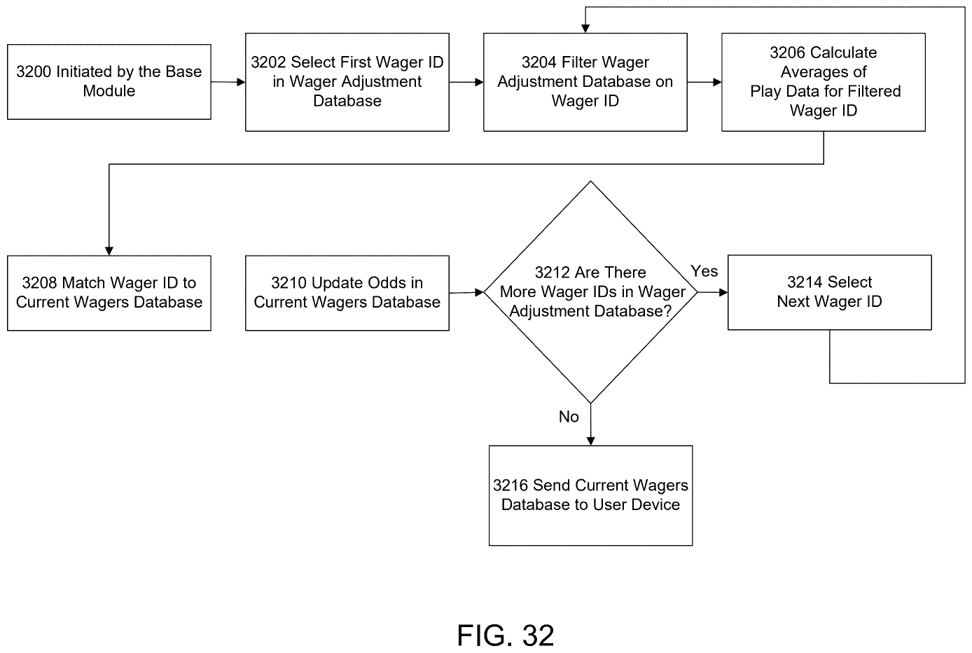

FIG. 32 illustrates a wager adjustment module, according to an embodiment.

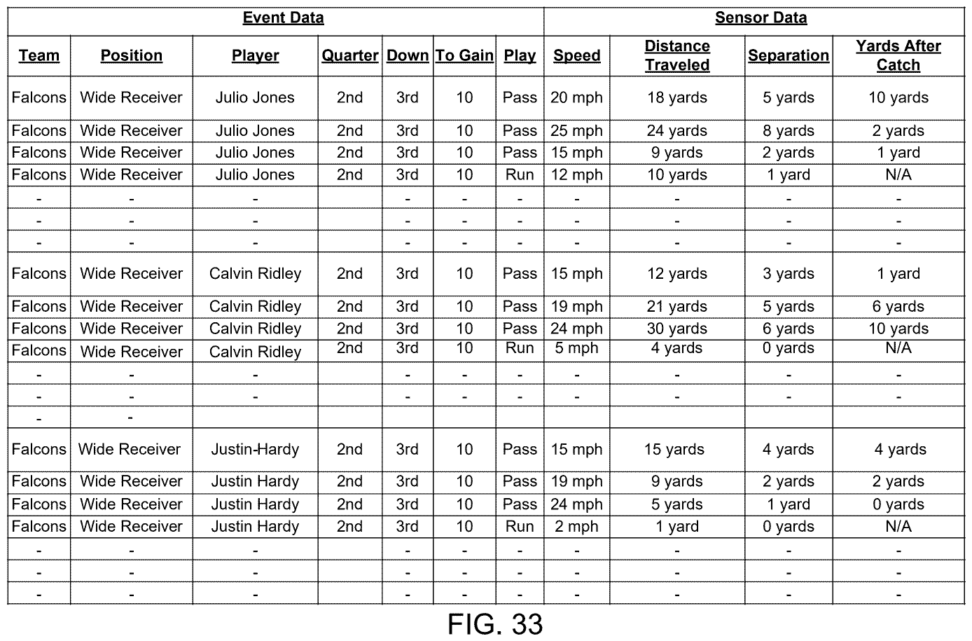

FIG. 33 illustrates a historic sensor database, according to an embodiment.

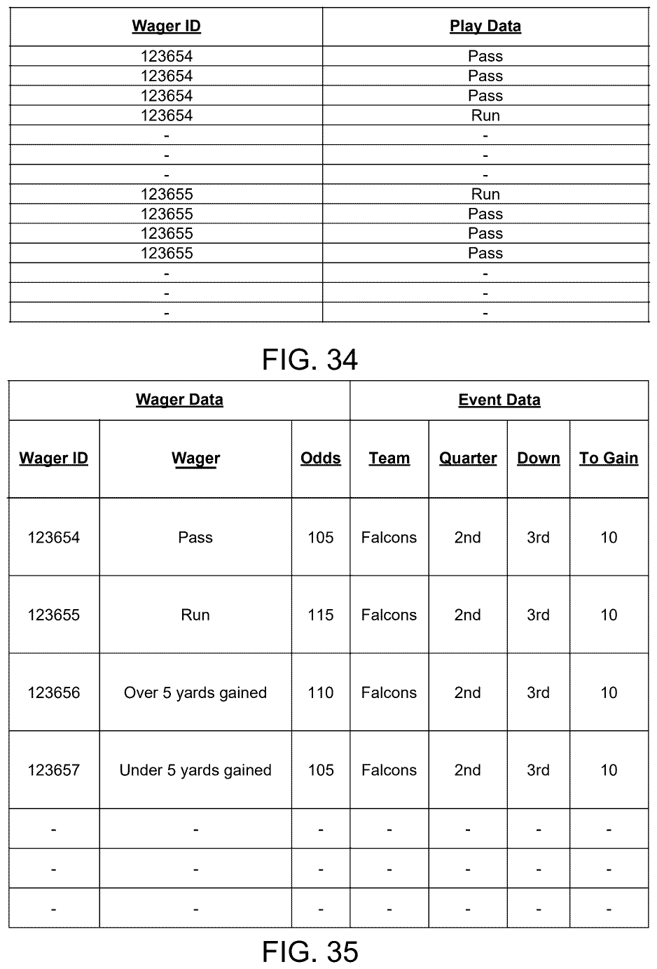

FIG. 34 illustrates a wager adjustment database, according to an embodiment.

FIG. 35 illustrates a current wagers database, according to an embodiment.

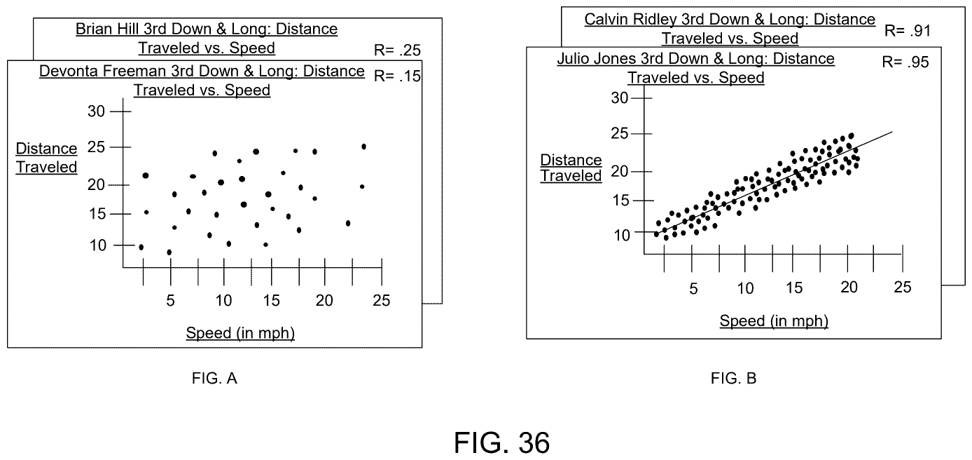

FIG. 36 illustrates an example of a wager module, according to an embodiment.

FIG. 29 displays a system using sensors 2904 to improve odds. This system includes of a live event 2902, for example a sporting event such as a football game, basketball game, baseball game, hockey game, tennis match, golf tournament, etc. The live event 2902 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 2902, such as the score of American football or the run line in baseball, or a series of action in the live event 2902. Sportsbooks have an amount of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event 2902 or at another location. The system may include a plurality of sensors 2904 that may be used such as motion sensors, temperature sensors, humidity sensors, cameras such as an RGB-D Camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball. In some embodiments, the sensor data is collected from the live event 2902 and sent to the server 2908 where it is stored in a historical sensor database 118. In some embodiments, the sensor data may be collected from a third party source and stored on the server 2908. Further, the availability of sensor data may be displayed to a user and/or any sensor data itself may be displayed to a user. Further, the availability or use of sensor data may be activated or deactivated by a user with respect to any participation in a wagering game or use in the making of wagers or adjusting of odds. The system also includes a cloud 2906 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance. The cloud 2906 may be communicatively coupled to server 2908 which may perform real time analysis on the type of play and the result of the play. The cloud 2906 may also be synchronized with game situational data, such as the time of the game, the score, location on the field, weather conditions, and the like which may affect the choice of play utilized. For example, in other exemplary embodiments, the cloud 2906 may not receive data gathered from sensors 2904 and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. The system may include a server 2908 which may perform real time analysis on the type of play and the result of a play or action. The server 2908 (or cloud 2906) may also be synchronized with game situational data, such as the time of the game, the score, location on the field, weather conditions, and the like which may affect the choice of play utilized. For example, in other exemplary embodiments, server 2908 may not receive data gathered from sensors 2904 and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. The server 2908 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user. The system may include a base module 2910 which initiates the wager module 2912 and then initiates the wager adjustment module 2914 and sends an updated bet database to the user device. The system may include a wager module 2912 which uses the data from the historic sensor database 2926 on previously collected sensor data with the same event data and performs correlations on the similar situations in order to determine if there is a correlation from the historic sensor data in order to extract and store the correlated action data in order to update the odds in the current wager database. The system may include a wager adjustment module 2914 which uses the correlated action data that was extracted via the wager module 2912 and stored in the wager adjustment database 2918 and determines the averages of the correlated action data to determine the adjustment needed for the current odds stored in the current wagers database 2920. The system may include a historic sensor database 2916 which stores all the historic sensor data previously collected from a live event 2902 by the server 2908. The system may include a wager adjustment database 2918 which stores the extracted correlated action data from the wager module 2912 along with the wager ID in order to be used during the wager adjustment module 2914 to properly modify the wager odds stored in the current wagers database 2920. The system may include a current wagers database 2920 which contains the current bets that users can place a wager on. A user device 2922 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device can leverage the sensors in for purposes such as automatic content recognition, augmented reality or the synchronization of screens between the user device interface and other displays. The interface(s) may either accept inputs from users or provide outputs to the users, or may perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a Graphical User Interface (GUI), a voice interface, or a web-based user-interface. Example wager module 2926 provides correlations of data.

FIG. 30 displays the base module 2910. The process begins with the base module 2910 initiating the wager module 2912, at step 3000. Then the base module 2910 initiates the wager adjustment module 2914, at step 3002. Once the current wagers database 2920 has been updated via the wager module 2912 and wager adjustment module 2914 the base module 2910 sends the current wager database to the user device, at step 3004.

FIG. 31 displays the wager module 2912. The process begins with the base module 2910 initiating the wager module 2912, at step 3100. The wager module 2912 looks up the wager in the current wagers database 2920, which stores all of the available wagers that are sent to the user devices to allow customer's clients to place wagers. Wager selection information can be a “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “Handle” or “juice” or “vigorish” or “off the board”, at step 3102. Then the wager module 2912 finds the event data related to the wager ID. For example, the first wager ID in the current wager database is 123654, at step 3104. The wager module 2912 then filters the historic sensor database 2916 for the event data associated with the wager ID. For example, for the first wager ID, 123654, in the current wager database has event data that is for the Falcons team, the second quarter, third down with ten yards to gain. The historic sensor database 2916 is filtered for the team to be the Falcons, for the second quarter, for third downs with ten yards to go. It should be noted that Wager data can be a “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “Handle” or “juice” or “vigorish” or “off the board”, at step 3106. Then the first participant, or player is selected which in this case would be Julio Jones. This is to continue to filter the historic sensor database 2916 in order to find the data points that have similar event data, in order to find the relevant sensor data that was previously collected in similar situations within the event, at step 3108. The wager module 2912 then performs correlations for all of the sensor data that has the same event data as the wager ID for the selected participant, at step 3110. It is then determined if there was a correlation coefficient above a predetermined threshold, such as 90%. If the correlation does not exceed the predetermined threshold the process continues to step 3118, at step 3112. If it is determined that the correlations exceed the predetermined threshold, for example above 90%, then the wager module 2912 extracts the reoccurring play data as well as the wager ID. For example, if there was a high correlation between the sensor data then the most reoccurring play data from the filtered historic sensor database 2916 is extracted, such as a pass or a run, at step 3114. The extracted data is stored in the wager adjustment database 2918, at step 3116. The wager module 2912 determines if there are any participants remaining, at step 3118. If there are participants remaining, the next participant is selected and the process returns to step 3110, at step 3120. If it is determined there are no additional participants remaining, it is then determined if there are any additional wagers in the current wager database. If there are additional wagers, the process returns to step 3104, at step 3122. If there are no additional wagers the process returns to the Base Module 2910, at step 3124.

FIG. 32 displays the wager adjustment module 2914. The process begins with the wager adjustment module 2914 being initiated by the base module 2910, at step 3200. The wager adjustment module 2914 selects the first wager ID in the wager adjustment database 2918, which stores the wager ID as well as the most reoccurring action from the filtered data from the process described in FIG. 31, at step 3202. Then the wager adjustment module 2914 filters the wager adjustment database 2918 on the wager ID, which leaves all the most reoccurring action or play result data that were calculated for the specific wager. Play data can be any data that indicates anything about the live game, such as, but not limited to audio of visual data that indicates “actions”, “sides”, “event” data, “total” data, “listed pitchers”, specific players, whistles, fouls, touchdowns, goals, yardage, player error, etc., at step 3204. The wager adjustment module 2914 then calculates the averages of all the most reoccurring action or play results, such as a pass or a run, for the filtered wager ID. The average of the play results may be used as probabilities of the action occurring which may be used to update or improve the current odds that are stored in the current wager database 2920, at step 3206. Then the wager adjustment module 2914 matches the wager ID from the wager adjustment database 2918 to the wager ID stored in the current wagers database 2920 in order to update the corresponding odds with the wager, at step 3208. The wager adjustment module 2914 then updates the current wagers database 2920 by using the probabilities calculated in step 3206 as the new odds for the wager. For example, wager ID 123654, which is a wager for a pass to occur on the next play which is 3rd and ten to go, otherwise known as a 3rd and long, is originally calculated with odds of −105. The averages calculated from the wager adjustment database 2918 show that out of four highly correlated instances three plays were passing plays and only one was a run play. So, the probability of the play being a pass would be 75%, or 33/100 which would translate to −300 and the odds for wager ID 123654 in the current wagers database 2920 would be updated to −300, at step 3210. It is then determined by the wager adjustment module 2914 if there are any remaining wager IDs in the wager adjustment database 2918, at step 3212. If it is determined there are more remaining wager IDs then the next wager ID is selected and the process returns to 3204, at step 3214. If there is no more remaining wager IDs from the wager adjustment database 2918 then the process returns to the base module 2910, at step 3216.

FIG. 33 displays the historic sensor database 2916 which contains all the sensor data collected from participants of previous live events. The database contains event data, which is information about the event at that specific period of time in the event such as which team the sensor data was collected for, the player or participant the sensor data was collected for, what position the player plays or is aligned for the specific play, the quarter or period of time in the event the data was collected, the down and distance to go and the resulting play, for example a pass or run. The database also contains the sensor data collected during the play such as the speed of the payer, the distanced the player traveled in total, the separation and the yards after catch. The database as currently shown is filtered for the event data and the participant in order to determine if there is any correlations between the sensor data collected and the outcome of the play to determine if the odds should be adjusted in the current wagers database 2920. In some embodiments, the sensor data collected may represent player's or participant's position on the field of play during an event.

FIG. 34 displays the wager adjustment database 2918 which stores the most re-occurring play data extracted from the wager module 2912 along with the wager ID in order to determine the probability of the upcoming play by determining the average occurrence of the play happening with similar event data and highly correlated sensor data through the process described in the wager adjustment module 2914. The database may contain the wager ID and the play data, such as a pass or a run.

FIG. 35 displays the current wagers database 2920 contains a list of all current wagers available to the users of the server 2908. The database may contain wager data such as the wager ID, a description of the wager, and the wager odds. The database may contain event data related to the wager such as the team, the quarter or time period for the upcoming play, the down, and the distance to gain.

FIG. 36 displays an example of the wager module 2926 and the resulting correlations. In the example for FIG. 36A, the data that is filtered by the event data and finding the various correlations with the sensor for the various participants on the field of play such as the running backs for the Atlanta Falcons Devonte Freeman, Brian Hill, etc. An example of non-correlated data with the event data and the sensor data and the running back being Devonte Freeman with a 15% (which is below the 90% threshold), therefore there is no correlation and no data should be extracted from the historic sensor database 2916 and stored in the wager adjustment database 2918. FIG. 36B displays an example of the correlations run in the wager module 2912. In this example the data that is filtered by the event data from the database and finding the various correlations between the sensor data filtered on similar event data and the participants which in this example are wide receivers for the Atlanta Falcons such as, Julio Jones, Calvin Ridley, etc. The highest correlated sensor data with similar event data was the distance traveled and speed collected from Julio Jones with a 95% correlation (which is above the 90% threshold). Then the most re-occurring data action or play from the historic sensor database 2916 is extracted, for example if the correlated sensor data had a passing play three times and a running play once, the most reoccurring play would be a passing play. So that data would be extracted, along with the original wager ID from the current wagers database 2920 and stored in the wager adjustment database 2918.

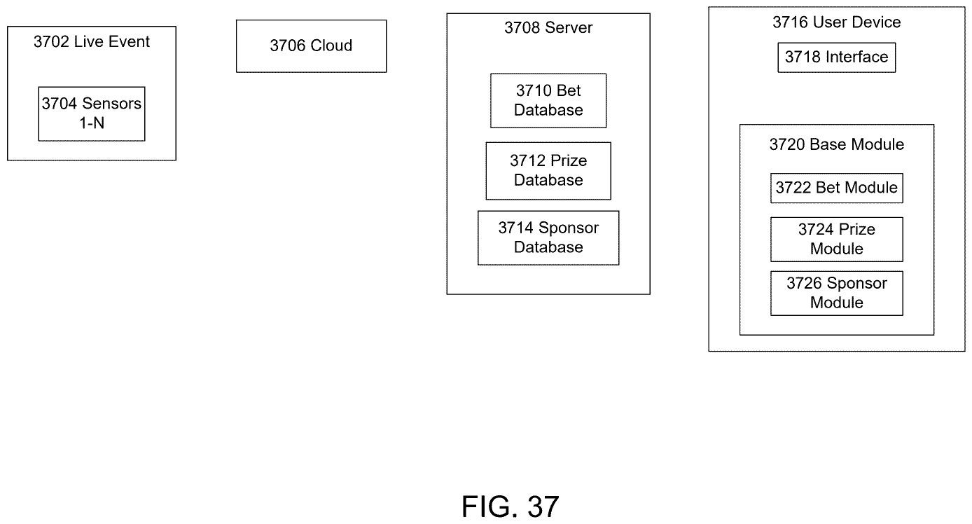

FIG. 37 illustrates a system for a concession, merchandise, and sponsored wagers, according to an embodiment.

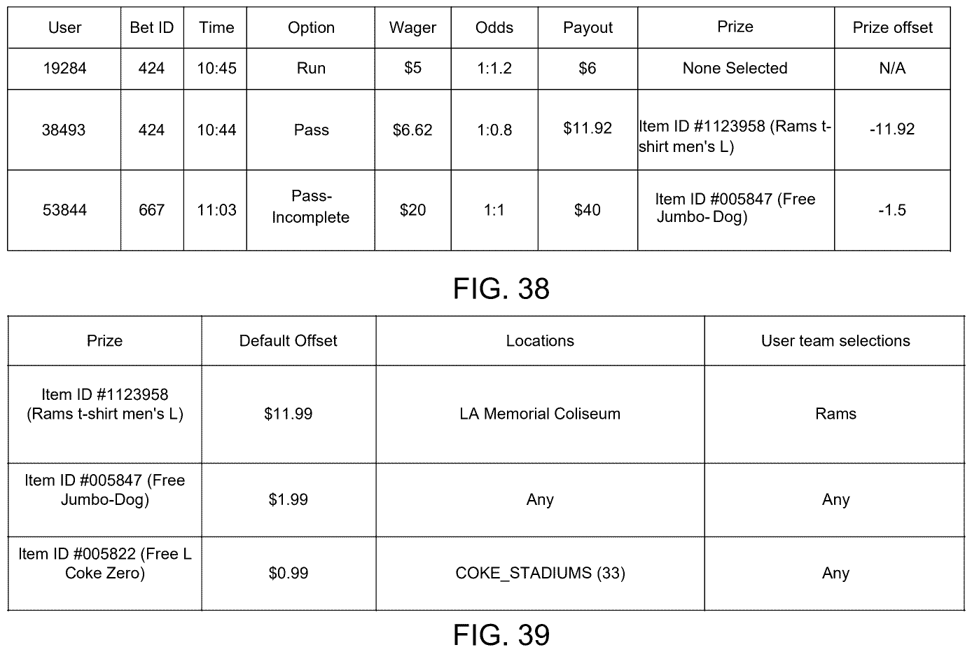

FIG. 38 illustrates a bet database, according to an embodiment.

FIG. 39 illustrates a prize database, according to an embodiment.

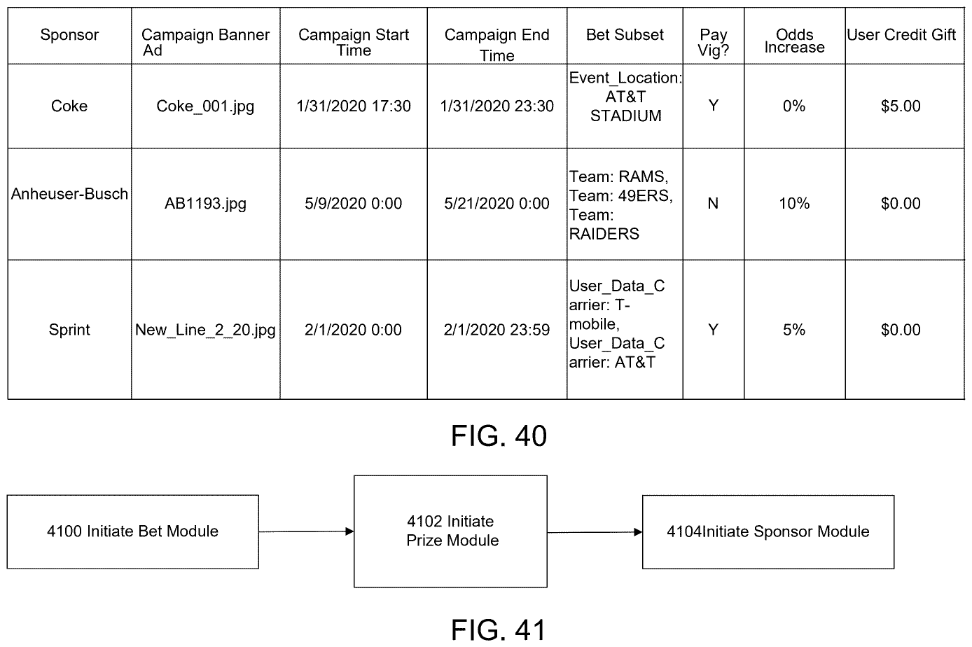

FIG. 40 illustrates a sponsor database, according to an embodiment.

FIG. 41 illustrates a base module, according to an embodiment.

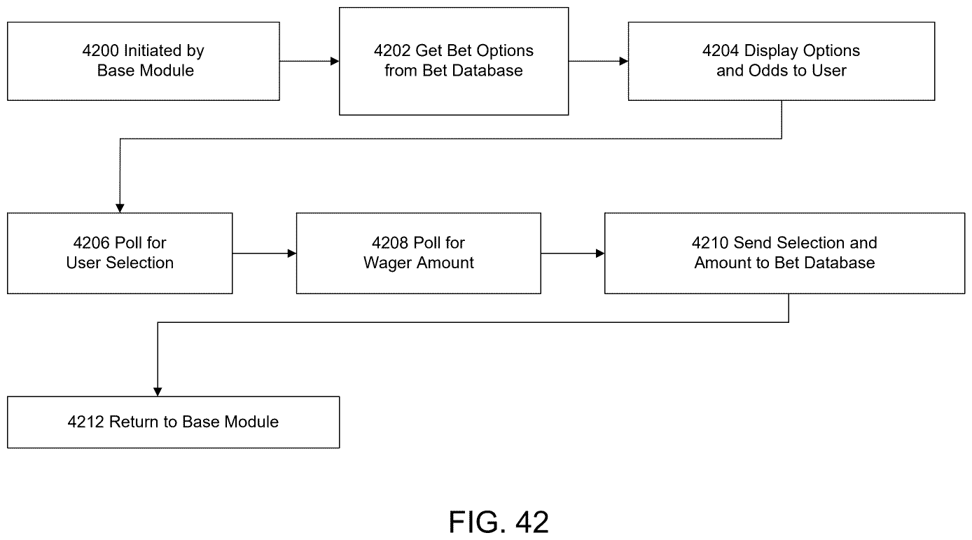

FIG. 42 illustrates a bet module, according to an embodiment.

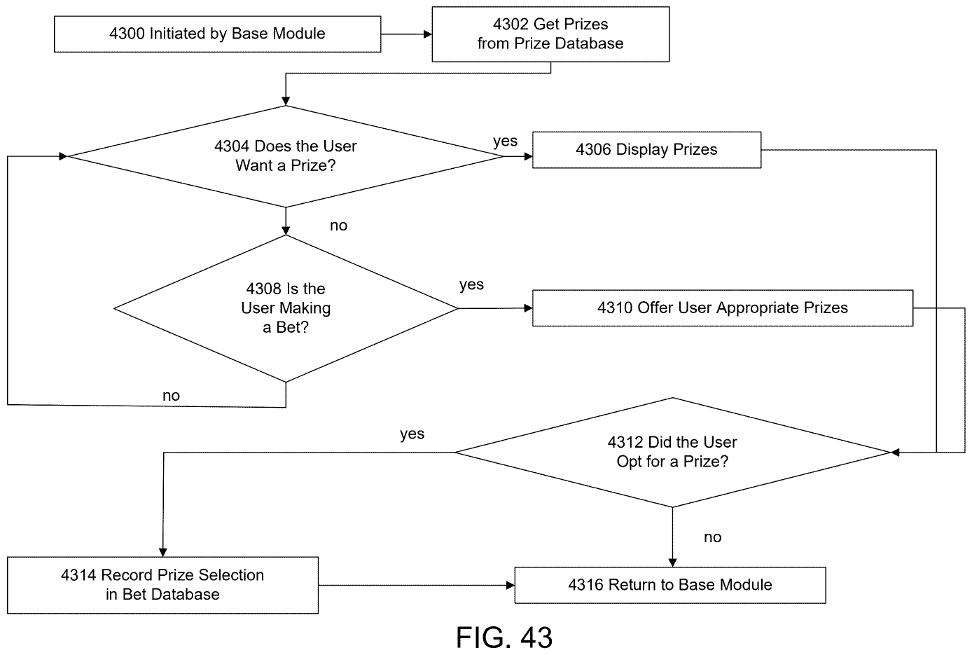

FIG. 43 illustrates a prize module, according to an embodiment.

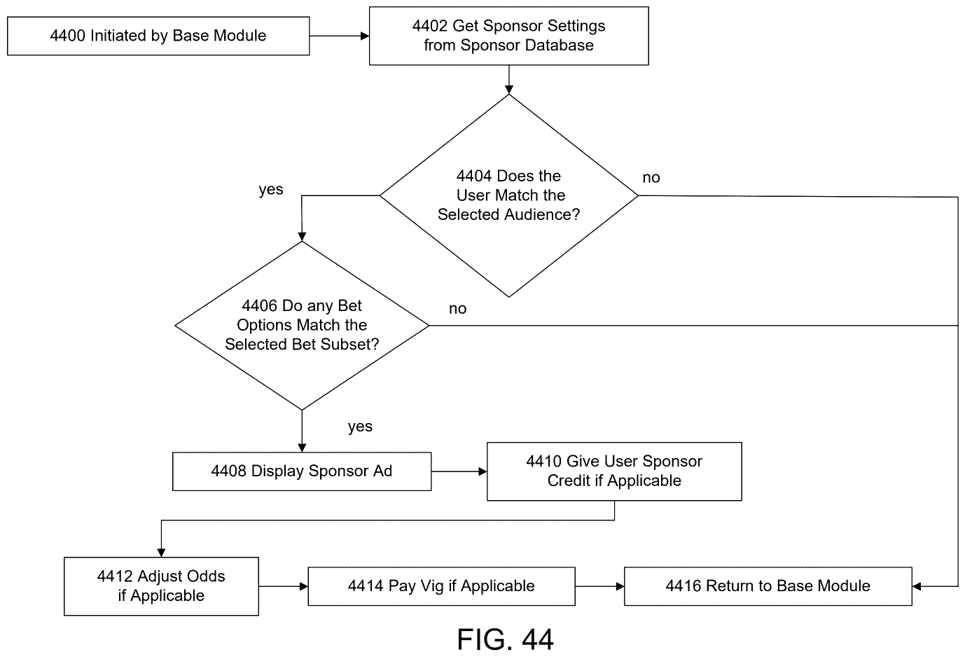

FIG. 44 illustrates a sponsor module, according to an embodiment.

FIG. 37 displays a system for a concession, merchandise, and sponsored wagers. This system includes a live event 3702, for example a sporting event such as a football game, basketball game, baseball game, hockey game, tennis match, golf tournament, eSports or digital game, etc. The live event 3702 will include some number of actions or plays, upon which a user, bettor, or customer can place a bet or wager, typically through an entity called a sportsbook. There are numerous types of wagers the bettor can make, including, but not limited to, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including, but not limited to, parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 3702, such as the score of American football or the run line in baseball, or a series of action in the live event 3702. Sportsbooks have an amount of bets they can handle, a limit of wagers they can take on either side of a bet before they will move the line or odds off of the opening line. Additionally, there are circumstances, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event 3702 or at another location.

The system may include a number of sensors 3704 that may be used such as motion sensors, temperature sensors, humidity sensors, cameras such as an RGB-D Camera which is a digital camera providing color (RGB) and depth information for every pixel in an image, microphones, radio frequency receiver, a thermal imager, a radar device, a lidar device, an ultrasound device, a speaker, wearable devices etc. Also, the sensors 3704 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball. The system also includes a cloud 106 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance.

The cloud 3706 may be communicatively coupled to server 3708 which may perform real time analysis on the type of play and the result of the play. The cloud 3706 may also be synchronized with game situational data, such as the time of the game, the score, location on the field, weather conditions, and the like which may affect the choice of play utilized. For example, in other exemplary embodiments, the cloud 3706 may not receive data gathered from sensors 3704 and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein.

The system may include a server 3708 which may perform real time analysis on the type of play and the result of a play or action. The server 3708 (or cloud 3706) may also be synchronized with game situational data, such as the time of the game, the score, location on the field, weather conditions, and the like which may affect the choice of play utilized. For example, in other exemplary embodiments, server 3708 may not receive data gathered from sensors 3704 and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein.

The server 3708 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user. A bet database 3710 contains the options that users can place a bet on, for example run or pass, and the associated odds of each option occurring. The bet database 3710 also contains which options the users have already placed bets on. In some embodiments the available options for a bet and the actual user bets may be stored in separate databases. The system may include a prize database 3712 that contains a list of prizes that may be won via betting in addition to or in lieu of a monetary value. For example, the reward for a winning bet may be a t-shirt or coupon for a free hotdog instead of cash or credit. Alternatively, the cash or credit payout may be reduced and awarded alongside the other prize instead of replaced. A sponsor database 3714 stores settings for sponsors who would like to sponsor bets. Sponsors may opt to pay the “vig” for a bet or may simply agree to increase the payout for winning bets in order to advertise directly to the users.

A user device 3716 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures.

Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device 3716 can leverage the sensors 3704 for purposes such as automatic content recognition, augmented reality or the synchronization of screens between the user device interface and other displays. The interface(s) 3718 may either accept inputs from users or provide outputs to the users, or may perform both the actions. In one case, a user can interact with the interface(s) using one or more user-interactive objects and devices. The user-interactive objects and devices may include user input buttons, switches, knobs, levers, keys, trackballs, touchpads, cameras, microphones, motion sensors, heat sensors, inertial sensors, touch sensors, or a combination of the above. Further, the interface(s) 3718 may either be implemented as a Command Line Interface (CLI), a Graphical User Interface (GUI), a voice interface, or a web-based user-interface. A base module 3720 initiates the bet module 3722, prize module 3724, and sponsor module 3726. A bet module 3722 accepts the user's bet selection. A prize module 3724 offers the user a chance to alter the reward for a winning bet to include a non-monetary prize such as a t-shirt or coupon for concessions. In some embodiments the user may choose a prize to bet on before selecting a bet. A sponsor module 3726 may display a sponsored message or advertisement and may allow the user to see how the sponsor has altered the bet payout, prizes, or vig.

FIG. 38 displays the bet database 3710. The database 3710 contains the options that users can place a bet on, for example run or pass, and the associated odds of each option occurring. The odds may be known, calculated by another module, or retrieved from a third party. The bet database 3710 also contains which options the users have already placed bets on along with the payout amount if they win, the money wagered, and any prize options. The database 3710 may contain a price offset which determines how much to subtract from the monetary winnings if a prize is awarded in lieu of or in addition to monetary winnings. In some embodiments the available options for a bet and the actual user bets may be stored in separate databases. User betting data can be used to inform future bet odds.

FIG. 39 displays the prize database 3712. The database 3712 contains a list of prizes that may be won via betting in addition to or in lieu of a monetary value. For example, the reward for a winning bet may be a t-shirt or coupon for a free hotdog instead of cash or credit. Alternatively, the cash or credit payout may be reduced and awarded alongside the other prize instead of replaced. An exemplary default prize offset is the amount to be subtracted from the monetary winnings when a prize is selected may be stored in the database. The default may be altered, for example, to move product, entice users to bet, or based on a sponsorship deal. Other data like restrictions on location and user targeting may be stored in the database 3712.

FIG. 40 displays the sponsor database 3714. The database 3714 contains settings for sponsors who would like to sponsor bets. Sponsors may opt to pay the “vig” for a bet or may simply agree to increase the payout for winning bets in order to advertise directly to the users. Sponsors may choose to effect bets for specific teams, events, players, or some other subset of bets for a specified amount of time. Sponsors may also make bets more appealing in other ways, for example, giving the user an amount of credits to make bets with, creating a leaderboard for users based on bet winnings, giving out sponsored prizes, matching some percent of a user's bet, etc.

FIG. 41 displays the base module 3720. The process begins with the base module 3720 initiating the bet module 3722 for using wager data which will retrieve the bet options from the bet database 3710 on the server 3708 for the current play data of the game. Play data can be any sensor data that indicates anything about the live game, such as, but not limited to audio or visual data that indicates “actions”, “sides”, “event” data, “total” data, “listed pitchers”, specific players, whistles, fouls, touchdowns, goals, yardage, player error, etc. Wager data can be a “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “Handle” or “juice” or “vigorish” or “off the board, at step 4100. The base module 3720 initiates the prize module 3724 which will retrieve the available prizes from the prize database 3712 on the server 3708 and display those prizes to the user or offer a prize at some point in the betting process to entice the user to bet, at step 4102. The base module 3720 initiates the sponsor module 3726 which will retrieve the sponsor settings from the sponsor database 3714 on the server 3708, display the sponsor's ad if there is one, and make changes to the betting options based on sponsor settings, for example, the cost of betting, betting payout or available prizes. It should be noted that the base module 3720 can be made available for access, reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”, at step 4104.

FIG. 42 displays the bet module 3722. The process begins with the bet module 3722 being initiated by the base module 3720, at step 4200. The bet module 3722 retrieves the possible options to bet on for the current play, quarter, game, or other unit of a sports game, along with the associated odds for the likelihood of that outcome, from the bet database 3710 on the server 3708, at step 4202. The bet module 3722 displays the bet options and odds to the user and allows the user to select a bet to make, at step 4204. The bet module 3722 polls the user's bet selection, when the user makes a bet selection the bet module 3722 prompts the user for a wager amount, at step 4206. The bet module 3722 polls for the user's wager amount, and in some embodiments the bet module 3722 will calculate the payout for each wager value the user enters before accepting a finalized wager submission from the user, at step 4208. The bet module 3722 sends the user's bet option and wager amount to the bet database 3710 on the server 3708, and in some embodiments there may be a warning or check that the user needs to respond to before the bet is finalized, at step 4210. The bet module 3722 returns to the base module 3720, at step 4212.

FIG. 43 displays the prize module 3724. The process begins with the prize module 3724 being initiated by the base module 3720, at step 4300. The prize module 3724 retrieves the available prizes from the prize database 3712 on the server 3708, some prizes may only be available at certain locations, times, events, or for certain users, the prize module 3724 only retrieves the prizes that are available given the conditions, for example, users at a stadium with Pepsi products would not be eligible to receive a prize of a large Coke product, at step 4302. The prize module 3724 determines if the user has indicated they want a prize, this may be done by having a button or link within the application which may be labeled as “Win a Prize” or “View Prizes”, or the user may have certain settings that indicate they prefer prizes to cash or credit payouts, at step 4304. If the user has indicated they want a prize, the prize module 3724 displays some or all of the prizes available. In some embodiments, the prizes may be tied to a specific bet option or set of bet options. In an embodiment, the user may select a prize to see what they would have to wager on each bet option in order to win the prize, at step 4306. If the user has not indicated they want a prize, the prize module 3724 determines if the user is making a bet, in an embodiment if the user has indicated they do not want a prize the prize module 3724 returns to the base module 3720 here, or alternatively is never initiated by the base module 3720, the prize module 3724 continues to check if the user is making a bet or wants a prize until the answer to one of those questions is positive or until returning to the base module 3720, at step 4308. If the user is making a bet, the prize module 3724 determines which prizes would be appropriate to offer in lieu of all or some of the payout, and what is appropriate may be determined by comparing the payout to the default offset value in the prize database 3712, for example if the user's bet would have a payout of $10, the prize module 3724 may offer the user a payout of $9 and a free hot dog voucher, but would not offer the user the chance to win a free car because the value of a car is substantially more than $10, in an embodiment, the prize module 3724 may offer a prize to entice the user to increase their wager. For example, the prize module 3724 could prompt the user to increase their wager by $10 and receive a free hot dog, at step 4310. The prize module 3724 determines if the user opted to win a prize in lieu of or in addition to a monetary payout, at step 4312. If the user opted to win a prize, the prize module 3724 may record that prize with the associated bet in the bet database 3710 on the server 3708, at step 4314. The prize module 3724 returns to the base module 3720, at step 4316.

FIG. 44 displays the sponsor module 3726. The process begins with the sponsor module 3726 being initiated by the base module 3720, at step 4400. The sponsor module 3726 retrieves the sponsor settings from the sponsor database 3714 on the server 3708, at step 4402. The sponsor module 3726 determines if the user is a member of the selected audience the sponsor intends to reach. This may mean the user is in the selected proximity of an event, that the user is a fan of a specific team or teams, or other information that allows the sponsor to tailor advertisements to their target market. If the user is not part of the selected audience, the sponsor module 3726 returns to the base module 3720, at step 4404. If the user is part of the selected audience, the sponsor module 3726 determines if at least one of the bet options matches the subset of bets that the sponsor intends to affect. For example, a sponsor may choose only to better the odds of bets on passes but not runs, or the sponsor may match up to a dollar on bets that are in favor of the home team. If none of the bet options are part of the selected bet subset, the sponsor module 3726 returns to the base module 3720. In another embodiment, the sponsor module 3726 continues to poll until at least one bet option is part of the selected bet subset, at step 4406. If the user is part of the selected audience and at least one bet option is part of the selected subset. The sponsor module 3726 displays the sponsor's ad to the user if the sponsor has provided one, at step 4408. If the sponsor has chosen to give users credit, the sponsor module 3726 will give those users credit and indicate that the credit is from the sponsor. Credit may be given once or multiple times and may require the user to view or interact with an advertisement, at step 4410. If the sponsor has chosen to adjust the odds in favor of users, the sponsor module 3726 will apply the adjustment. In an exemplary embodiment the user will be shown the adjusted and unadjusted odds and the difference will be attributed to the generosity of the sponsor, at step 4412. If the sponsor has chosen to pay the vig, and there is a vig, then the user will not have to pay the vig. In an exemplary embodiment, the user would be made aware that the sponsor is paying the vig on their behalf, at step 4414. The sponsor module 3726 returns to the base module 3720, at step 4416.

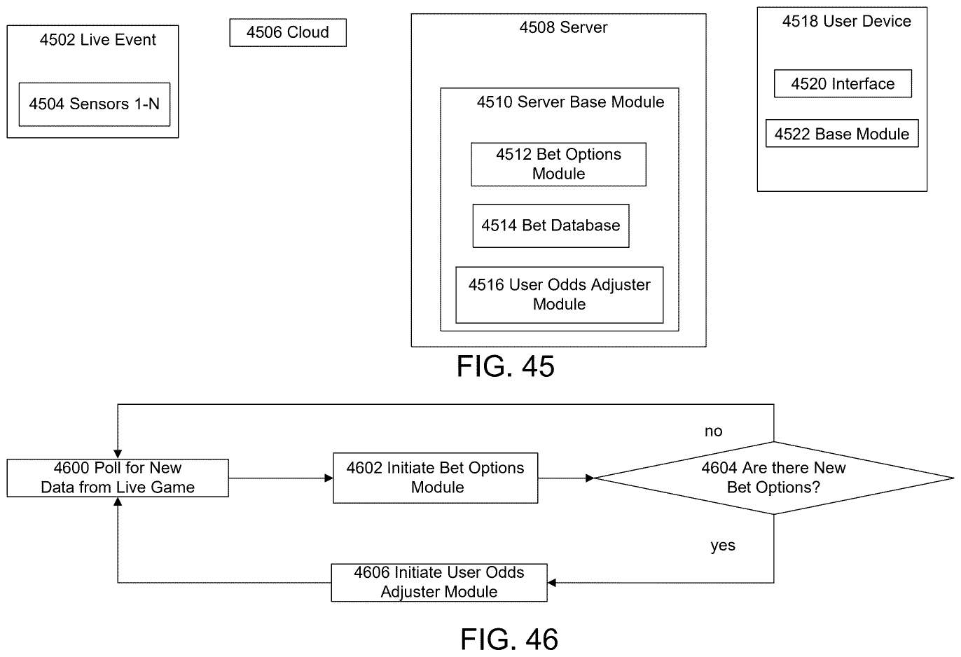

FIG. 45 illustrates a system for a micro-event individualized odds adjuster, according to an embodiment.

FIG. 46 illustrates a server base module, according to an embodiment.

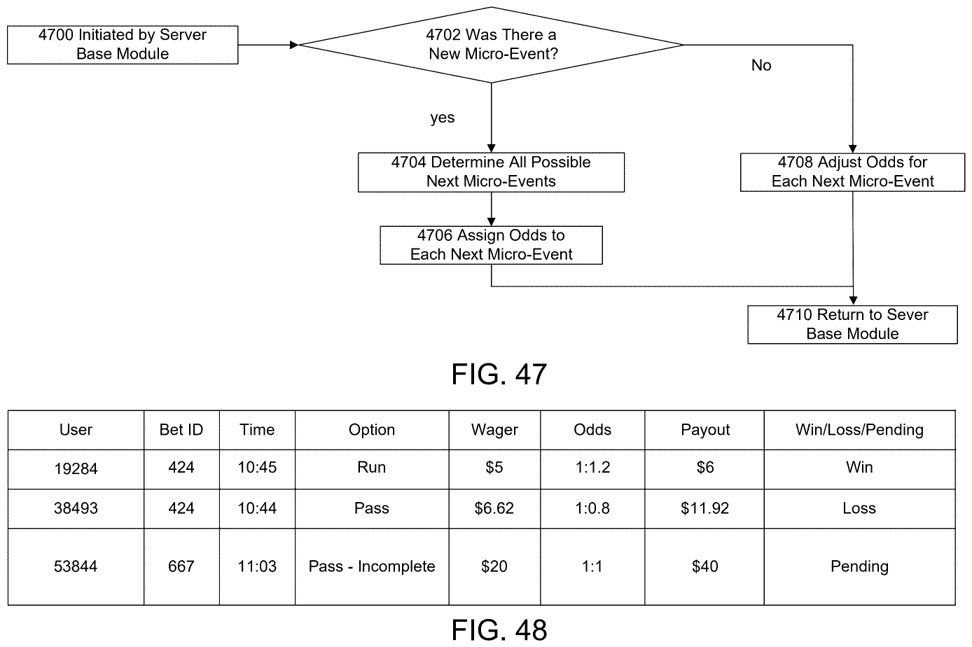

FIG. 47 illustrates a bet options module, according to an embodiment.

FIG. 48 illustrates a bet database, according to an embodiment.

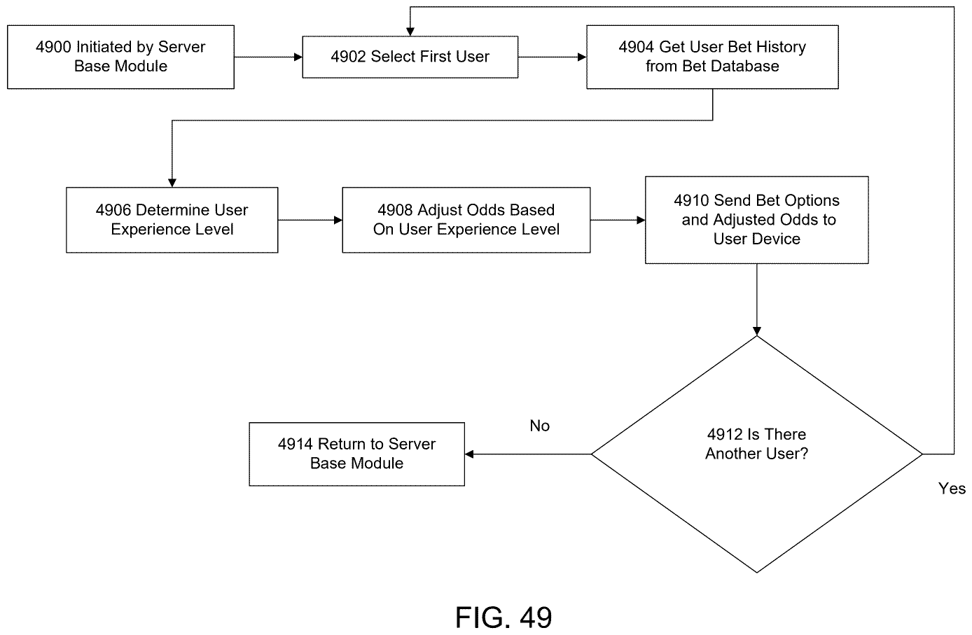

FIG. 49 illustrates a user odds adjuster module, according to an embodiment.

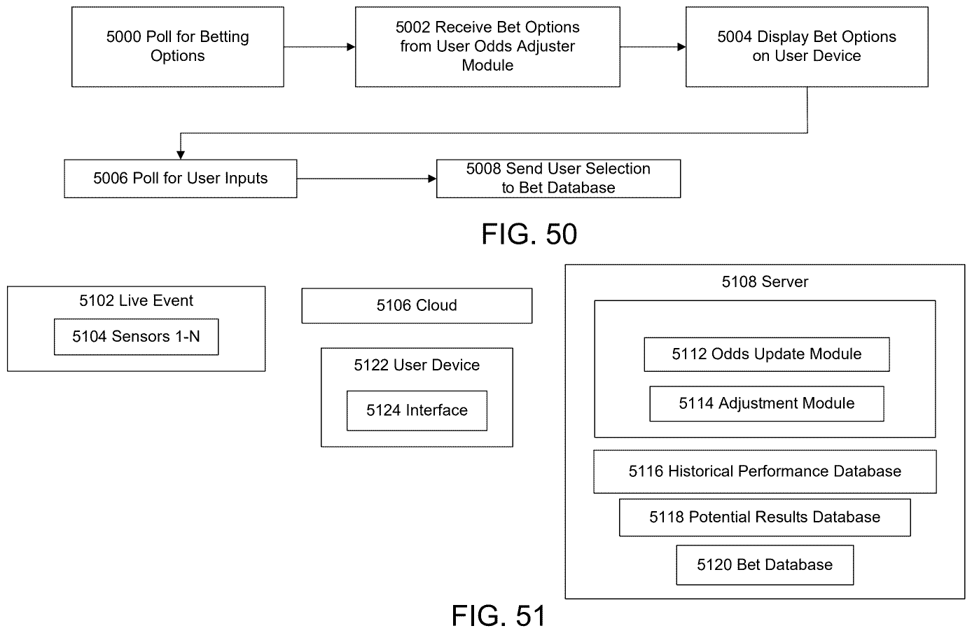

FIG. 50 illustrates a base module, according to an embodiment.

FIG. 45 displays a micro-event individualized odds adjuster. This system includes a live event 4502, for example a sporting event such as a football game, basketball game, baseball game, hockey game, tennis match, golf tournament, etc. The live event 4502 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 4502, such as the score of American football or the run line in baseball, or a series of action in the live event 4502. Sportsbooks have an amount of bets they can handle, a limit of wagers they can take on either side of a bet before they will move the line or odds off of the opening line. Additionally, there are circumstances, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live events in the future. Sportsbooks need to offer payment processing services in order to cash out customers. This can be done at kiosks at the live event 4502 or at another location. The system may include a plurality of sensors 4504 that may be used such as motion sensors, temperature sensors, humidity sensors, cameras such as an RGB-D Camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors 4504 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball. The system also includes a cloud 4506 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance. The cloud 4506 may be communicatively coupled to server 4508 which may perform real time analysis on the type of play and the result of the play. The cloud 4506 may also be synchronized with game situational data, such as the time of the game, the score, location on the field, weather conditions, and the like which may affect the choice of play utilized. For example, in other exemplary embodiments, the cloud 4506 may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. The system may include a server 4508 which may perform real time analysis on the type of play and the result of a play or action. The server 4508 (or cloud 4506) may also be synchronized with game situational data, such as the time of the game, the score, location on the field, weather conditions, and the like which may affect the choice of play utilized. For example, in other exemplary embodiments, server 4508 may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein. The server 4508 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user. A server base module 4510 receives data from the live event 4502 and feeds that data into the bet options module 4512. A bet options module 4512 determines the possible next micro-events from the information from the live event 4502 and determines the odds of each micro-event occurring. A bet database 4514 stores the user's bet selection, wager amount, and if the bet was won, lost, or is still pending. A user odds adjuster module 4516 adjusts the odds for an individual user based on that user's betting history and experience level. A user device 4518 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provide for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device 4518 can leverage the sensors in for purposes such as automatic content recognition, augmented reality or the synchronization of screens between the user device interface(s) 4520 and other displays. The interface(s) 4520 may either accept inputs from users or provide outputs to the users or may perform both the actions. In one case, a user can interact with the interface(s) 4520 using one or more user-interactive objects and devices. The user-interactive objects and devices may include user input buttons, switches, knobs, levers, keys, trackballs, touchpads, cameras, microphones, motion sensors, heat sensors, inertial sensors, touch sensors, or a combination of the above. Further, the interface(s) 4520 may either be implemented as a Command Line Interface (CLI), a Graphical User Interface (GUI), a voice interface, or a web-based user-interface. A base module 4522 displays the betting options to the user and records the user's bet selections.

FIG. 46 displays the server base module 4510. The process begins with the server base module 4510 polling the live game for new data at step 4600. The server base module 4510 initiates the bet options module 4512 when there is new data from the live game and passes in that data, at step 4602. The server base module 4510 determines if there are new bet options from the bet options module 4512; if there are no bet options or the bet options did not change, the server base module 4510 continues to poll for new data, at step 4604. If there are new bet options, the server base module 4510 initiates the user odds adjuster module 4516 and passes in those bet options, at step 4606.

FIG. 47 displays the bet options module 4512. The process begins with the bet options module 4512 being initiated by the server base module 4510 which passes in new data from the live event 4502, which may be in the form of sensory data from sensors, or event data, for example, 1st down, 2nd inning, 3rd quarter, at step 4700. The bet options module 4512 determines if the data from the live game indicates that there is a new micro-event, for example if the down has changed, there is a new batter, possession of the ball has changed, this may be determined by a direct signal from the live game that a change has happened, or by the bet options module 4512 comparing the current data against some historical database, in some embodiments the bet options module 4512 may temporarily store data on at least one previous micro-event, at step 4702. If the data from the live game indicates there is a new micro-event, the bet options module 4512 determines all possible micro events that could occur next based on the rules of the game, for example, if the current play is second down and there was no interception, the possible micro-events for third down may be: pass, run, punt, pass (incomplete), timeout call, etc. In some embodiments the next micro-events might only be limited to a few options, at step 4704. The bet options module 4512 assigns odds to each next micro-event, these odds may be based on a default value, based on historical data, based on current data from the live game, based on what users are betting on, based on any other method of determining odds for a wager, or based on any combination of methods, at step 4706. If the data from the live game indicates there is no new micro-event, the bet options module 4512 adjusts the odds based on the new data, for example if the sensory data from the live game indicates a change in wind speed, the odds of a pass may be reduced because historically coaches or players may avoid making passes into high winds, at step 4708. The bet options module 4512 returns the bet options to the server base module 4510, at step 4710.

FIG. 48 displays the bet database 4514. The bet database 4514 contains the user's bet selection, wager amount, if the bet was won, lost, or is still pending, and any other metrics that may be useful to determine user behavior and experience level, which could be determined to be sport or sports knowledge or sport or sports betting knowledge. For example, “win streak” might be a data point that records a user's consecutive wins. Some data may be calculated by other modules.

FIG. 49 displays the user odds adjuster module 4516. The process begins with the user odds adjuster module 4516 being initiated by the server base module 4510 which also passes in new bet options. New bet options may refer to entirely new options, or options who's associated odds have been adjusted based on live data, at step 4900. The user odds adjuster module 4516 selects a first user, that first user is any user whose odds have not already been adjusted. In an exemplary embodiment, active users would receive priority over inactive users, at step 4902. The user odds adjuster module 4516 retrieves all bets the user has made from the bet database 4514, at step 4904. The user odds adjuster module 4516 determines the user's experience level or sport/sports knowledge using data from their betting behavior; for example, users with more wins than losses will have a higher experience level than users with more losses than wins, users with bets over a longer period of time may have more experience than new users, and users who bet frequently may have more experience than infrequent users. Experience may be based on any or all betting metrics, experience may be tied to bets on a specific sport, team, type of play, etc. In an embodiment, artificial intelligence may be used to determine the optimal parameters for measuring user experience, in another embodiment experience level would be stored in a separate database and the saved value could be used if there have been no changes. In a specific, non-limiting example, users are assigned a football expertise score including points, each win of a football-based bet awards the user 3 points, and each loss removes 2 points. After a week without any bets on a football game the user loses 1 point per day, at an example of step 4906. The user odds adjuster module 4516 adjusts the odds of each bet option based on the user's experience level. In an embodiment, users may be bracketed into categories based on experience level such as novice, intermediate, and expert, and each category may have a direct modifier for odds such as 5%, 10%, and 15% respectively. In another embodiment experience may be a gradient and odds may be adjusted on a spectrum, for example, the least experienced player may have 0% adjustment but the adjustment increases as a function of experience up to 20% for the most experienced user. In a specific, non-limiting example, users are assigned a football expertise score including points, a score of 100 or less indicates the user is a novice and receives no adjustment to their odds, users between 100 and 1,000 points are intermediate users and odds are adjusted by 5%, users with a score between 1,000 and 10,000 points are experts and odds are adjusted by 10%. Users above 10,000 points are grandmasters and are given a leaderboard rank based on their football expertise score, the bottom 20%, or first quintile, of grandmasters have their odds adjusted by 11%, the 2nd quintile of grandmasters have their odds adjusted by 12%, the 3rd quintile of grandmasters have their odds adjusted by 13%, the 4th quintile of grandmasters have their odds adjusted by 14%, and the top 20% of users ranked by football expertise score have their odds adjusted by 15%. In each case the original odds in the bet database 4514 would be multiplied by the corresponding adjustment before being sent to the user device 4518, at step 4908. The user odds adjuster module 4516 sends the bet options and adjusted odds to the user device 4518. In another embodiment, the bet options and adjusted odds are stored in a database until the user device 4518 requests that information. In another embodiment the user odds adjustment module sends only the adjusted odds and the bet options are sent by another module. In another embodiment the user odds adjustment module sends only the adjustment and the original odds are sent by another module, at step 4910. The user odds adjuster module 4516 determines if there is another user for which adjusted odds have not been calculated. If it is determined there is another user for which adjusted odds have not been calculated, the user odds adjuster module 4516 returns to step 4502, at step 4912. If there are no other users, the user odds adjuster module 4516 returns to the server base module 4510, at step 4914.

FIG. 50 displays the base module 4522. The process begins with the base module 4522 polling the bet options module 4512 on the server 4508. In some embodiments if there are no bet options available the base module 4522 will display a message to indicate to the user that they cannot bet, for example, “betting currently closed”, “waiting on new play data”, or “event ended”, at step 5000. The base module 4522 receives bet options and odds from the user odds adjuster module 4516 on the server 4508, at step 5002. The base module 4522 displays the bet options and associated odds to the user and prompts the user for their bet selection and wager amount, at step 5004. The base module 4522 polls for the user's bet selection and wager amount before continuing, at step 5006. The base module 4522 sends the user's bet selection and wager amount to the bet database 4514 on the server 4508, at step 5008.

FIG. 51 illustrates a system for improving odds based on physiological data, according to an embodiment.

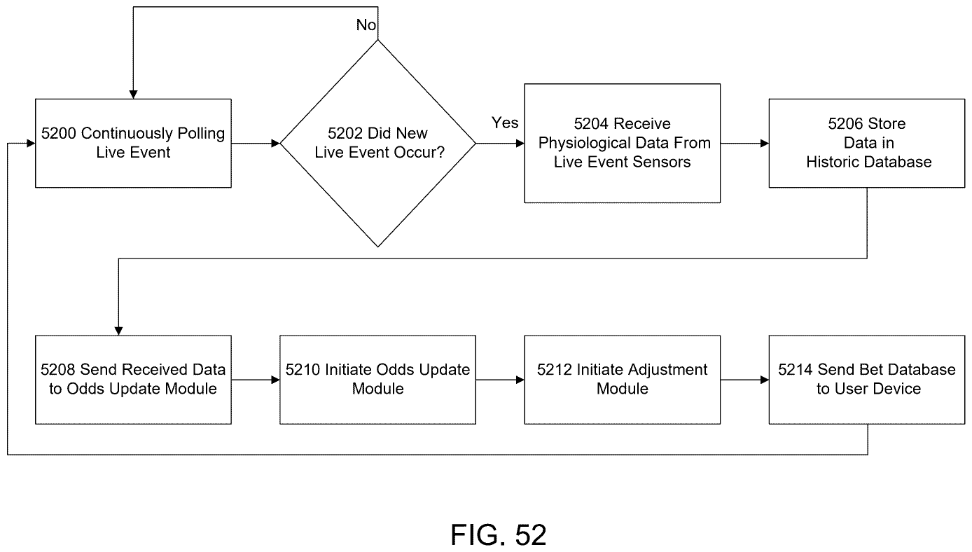

FIG. 52 illustrates a base module, according to an embodiment.

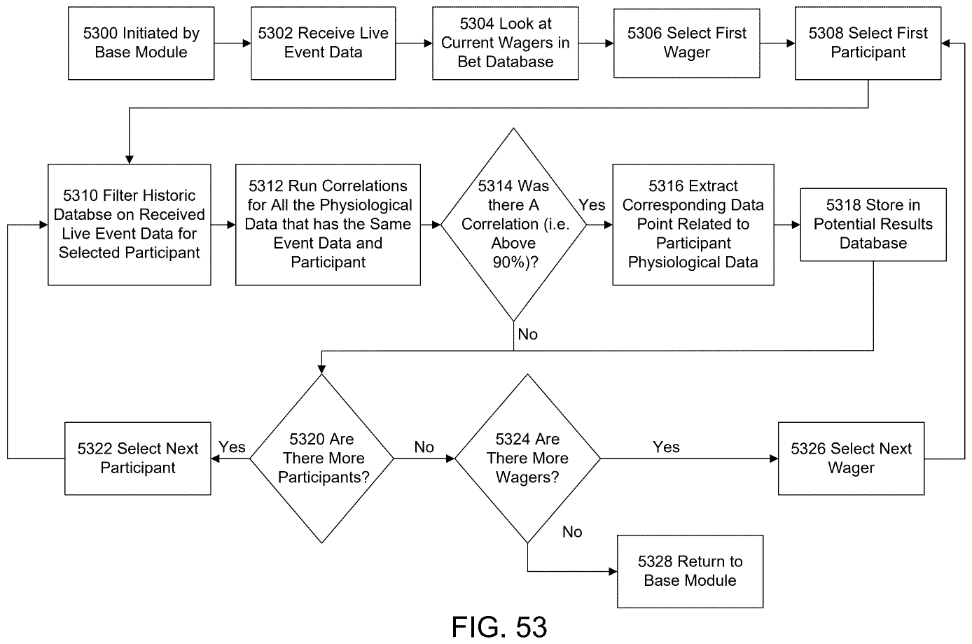

FIG. 53 illustrates an odds update module, according to an embodiment.

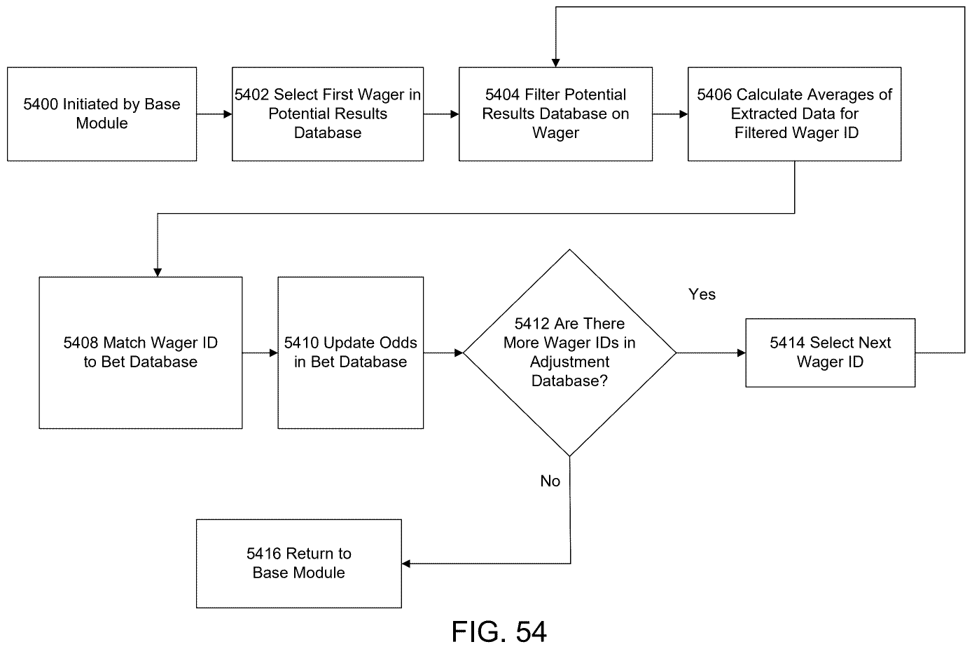

FIG. 54 illustrates an adjustment module, according to an embodiment.

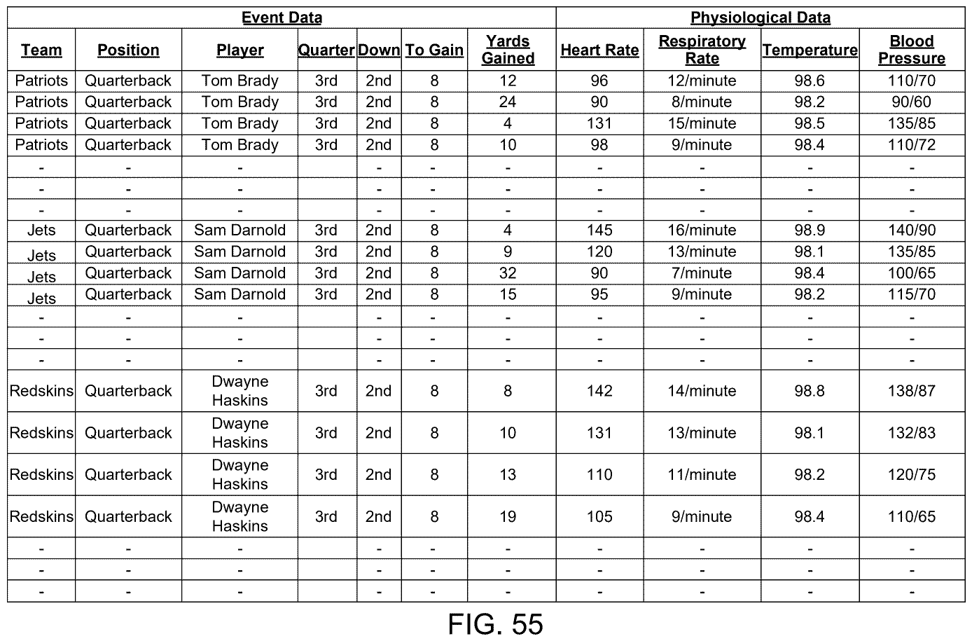

FIG. 55 illustrates a historic database, according to an embodiment.

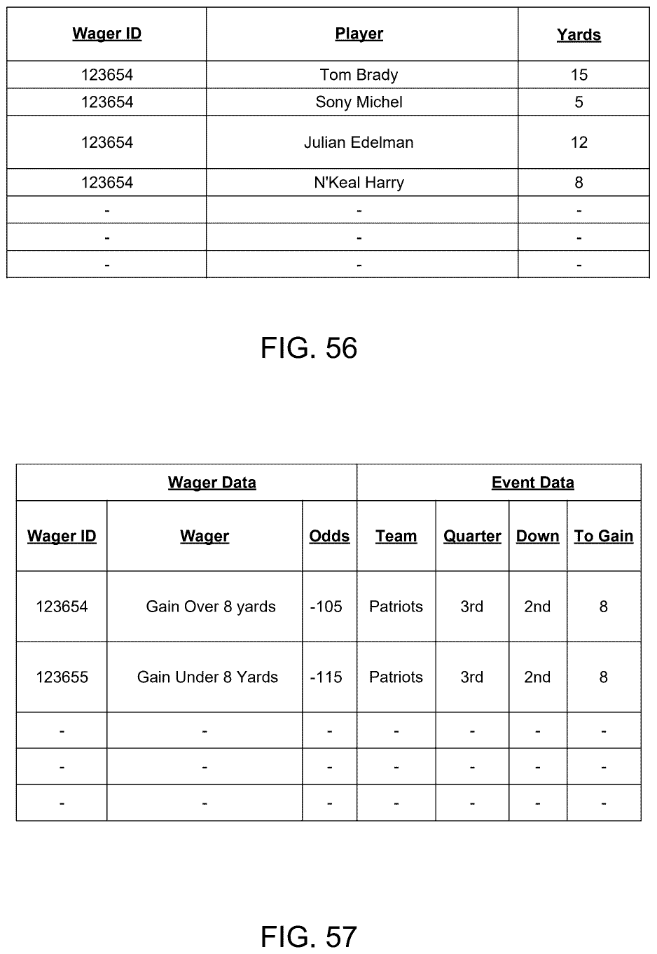

FIG. 56 illustrates a potential results database, according to an embodiment.

FIG. 57 illustrates a bet database, according to an embodiment.

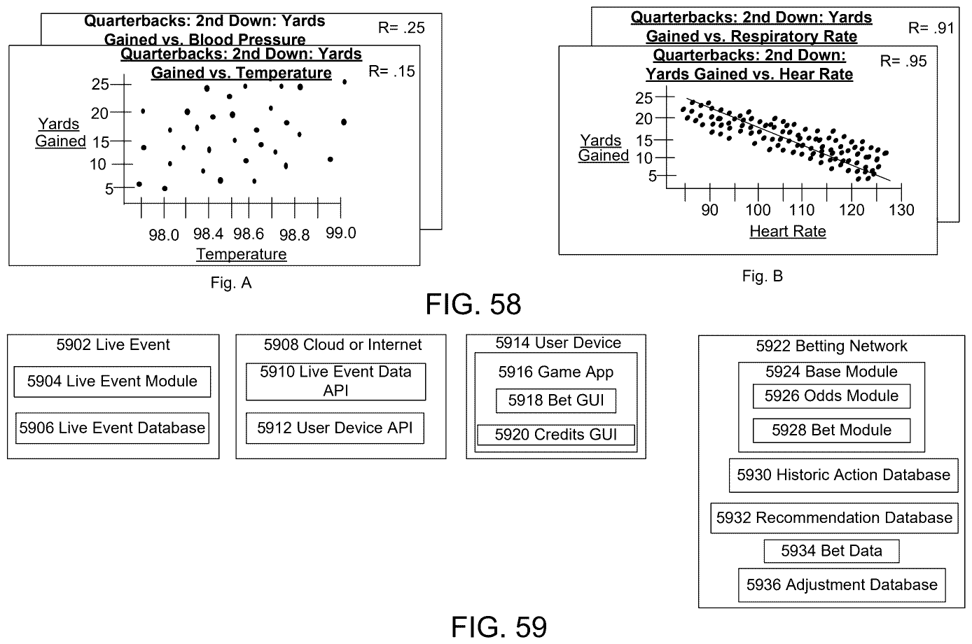

FIG. 58 illustrates an example of an odds update module, according to an embodiment.

FIG. 51 shows a system for improving odds based on physiological data. This system includes a live event 5102, for example a sporting event such as a football game, basketball game, baseball game, hockey game, tennis match, golf tournament, etc. The live event 5102 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 5102, such as the score of American football or the run line in baseball, or a series of action in the live event 5102. Sportsbooks have an amount of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event 5102 or at another location, at element 5102. The system may include a plurality of sensors 5104 that may be used such as motion sensors, temperature sensors, humidity sensors, cameras such as an RGB-D Camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball. The plurality of sensors 5104 may include sensors 5104 for physiological or medical data such as heart rate, pulse, respiratory rate, body temperature, or body mass index (BMI). In some embodiments, the sensor data is collected from the live event 5102 and sent to the server 5108 where it is stored in a historical sensor database. In some embodiments, the sensor data may be collected from a third party source and stored on the server, at element 5108. The system also includes a cloud 5106 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance. The cloud 5106 may be communicatively coupled to server 5108 which may perform real time analysis on the type of play and the result of the play. The cloud 5106 may also be synchronized with game situational data, such as the time of the game, the score, location on the field, weather conditions, and the like which may affect the choice of play utilized. For example, in other exemplary embodiments, the cloud 5106 may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein, at element 5106. The system may include a server 5108 which may perform real time analysis on the type of play and the result of a play or action. The server 5108 (or cloud 5106) may also be synchronized with game situational data, such as the time of the game, the score, location on the field, weather conditions, and the like which may affect the choice of play utilized. For example, in other exemplary embodiments, server 5108 may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein. The server 5108 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user, at element 5108. The system may include a base module 5112 which receives performance data from the live event 5102, stores the data in the historic database, initiates the odds update module 5112 and then initiates the adjustment module 5114 and sends an updated bet database 5120 to the user device, at element 5122. The system may include odds update module 5112 which uses the data from the historic database 5126 on previously collected physiological data with the same event data and performs correlations on the similar situations in order to determine if there is a correlation from the historic data in order to extract and store the correlated data corresponding with a participants performance data in order to update the odds in the bet database 5120, at element 5112. The system may include an adjustment module 5114 which uses the extracted correlated data that was extracted via the odds update module 5112 and stored in the historic database 5116 and determines the averages of the correlated data to determine if the odds in the bet database 5120 should be adjusted, at element 5114. The system may include a historic database 5116 which stores all the historic data previously collected from a live event 5102 by the server, at element 5108. The system may include a potential results database 5118 which stores the extracted corresponding correlated data to the participants' performance data from the odds update module along with the wager ID in order to be used during the adjustment module to properly modify the wager odds stored in the bet database, at element 5118. The system may include a bet database 5120 which contains the current bets that users can place a wager on, at element 5120. A user device 5122 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device 5122 can leverage the sensors in for purposes such as automatic content recognition, augmented reality or the synchronization of screens between the user device interface and other displays. The interface(s) may either accept inputs from users or provide outputs to the users, or may perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a Graphical User Interface (GUI), a voice interface, or a web-based user-interface, at element 5124. This figure displays an example of the odds update module and the resulting correlations, at element 5126.

FIG. 52 displays the base module 5110. The process begins with the base module 5110 continuously polling the live event 5102 in order to receive new physiological data of the participants of the event, at step 5200. The base module 5110 determines if a new live event 5102 has occurred, if no new event has occurred then the base module 5110 returns to step 5200 in order to continuously poll for a new live event 5102, at step 5202. If it is determined that a new live event 5102 has occurred the base module 5110 receives physiological data from the live event sensors. Along with the physiological data the base module 5110 may receive event information about the current situation within the event, such as the time period of the event, at step 5204. The received data from the live event 5102 is stored in the historic database 5116, at step 5206. The base module 5110 then sends the data that was received from the live event 5102 to the odds update module 5112, at step 5208. The base module 5110 then initiates the odds update module 5112, at step 5210. Once the process described in the odds update module 5112 is complete the process returns to the base module 5110 where the base module 5110 initiates the adjustment module 5114, at step 5212. Once the process described in the adjustment module 5114 is complete, the process returns to the base module 5110 where the base module 5110 sends the bet database, which has been updated via the processes described in the odds update module 5112 and adjustment module 5114, to the user device 5122. It should be noted that odds are taken on play data wagers. Wager data can be a “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “Handle” or “juice” or “vigorish” or “off the board”. Play data can be any sensor data that indicates anything about the live game, such as, but no limited to audio of visual data that indicates “actions”, “sides”, “event” data, “total” data, “listed pitchers”, specific players, whistles, fouls, touchdowns, goals, yardage, player error, etc. It should be noted that the base module 5110 can be made available for access, reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”, at step 5214.

FIG. 53 displays the odds adjustment module 5112. The process begins with the base module 5110 initiating the odds update module 5112, at step 5300. Then the odds update module 5112 receives the live event data from the base module 5110, which may include information related to the event. For example, in American football the odds update module 5112 may receive the offensive team, players on the field, the time or quarter of the event, the down and distance, etc., at step 5302. The odds update module 5112 looks up the wager in the bet database, which stores all of the available wagers that are sent to the user devices to allow customer's clients to place wagers. Bet selection information can be a “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “handle” or “juice” or “vigorish” or “off the board”, at step 304. Then the odds update module 5112 selects the first wager stored in the bet database. For example, the first wager ID in the current wager database is 123654, at step 5306. Then the first participant, or player is selected which in this case would be Tom Brady. This is to continue to filter the historic database 5116 in order to find the data points that have similar event data, in order to find the relevant physiological data that was previously collected in similar situations within the event, at step 5308. The odds update module 5112 then filters the historic database 5116 for the event data associated with the wager ID. For example, for the first wager ID, 123654, in the bet database 5120 has event data that is for the Patriots team, the third quarter, second down with eight yards to gain. The historic database 5116 is filtered for the by the position of the participant selected, for the third quarter, for second downs with eight yards to go. It should be noted that wager data can be a “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tic” or “pick” or “pick-em” or “middle” or “parlay” or “round robin” or “teaser” or “prop bet” or “first-half-bet” or “half-time-bet” or “futures bet” or “future” or “handle” or “juice” or “vigorish” or “off the board”, at step 310. The wager module 5112 then performs correlations for all of the physiological data that has the same event data as the wager ID for the selected participant, at step 5312. It is then determined if there was a correlation coefficient above a predetermined threshold, such as 90%. If the correlation does not exceed the predetermined threshold the process continues to step 5318, at step 5314. If it is determined that the correlations exceed the predetermined threshold, for example above 90%, then the odds update module extracts the corresponding data related to the participants current physiological data. For example, if Tom Brady has a heart rate of 96 the corresponding data related to the correlated data would be 15 yards, as shown in FIG. 53, at step 5316. The extracted data is stored in the potential result database 5118, at step 5318. The odds update module 5112 determines if there are any participants remaining, at step 5320. If there are participants remaining, the next participant is selected and the process returns to step 5310, at step 5322. If it is determined there are no additional participants remaining, it is then determined if there are any additional wagers in the bet database, at step 5324. If it is determined that there are additional wagers remaining in the bet database, the next wager is selected and the process returns to step 5308, at step 5326. If it is determined there are no additional wagers the process returns to the base module 5110, at step 5328.

FIG. 54 displays the adjustment module. The process begins with the adjustment module 5114 being initiated by the base module 5110, at step 5400. The adjustment module 5114 selects the first wager ID in the potential results database 5118, which stores the wager ID as well as the corresponding data for the participant and the correlated data from the process described in FIG. 54, at step 5402. Then the adjustment module 5114 filters the potential results database 5118 on the wager ID, which leaves all the extracted corresponding data or play result data, in this example the yards gained, that were calculated for the specific wager. Play data can be any data that indicates anything about the live game, such as, but not limited to audio or visual data that indicates “actions”, “sides”, “event” data, “total” data, “listed pitchers”, specific players, whistles, fouls, touchdowns, goals, yardage, player error, etc., at step 5404. The adjustment module 5114 then calculates the averages of all the extracted corresponding data or play results, such as yards gained, for the filtered wager ID. The average of the play results may be used in order to update the current odds stored in the bet database, at step 5406. Then the adjustment module 5114 matches the wager ID from the potential results database 5118 to the wager ID stored in the bet database 5120 in order to update the wager odds, at step 5408. The adjustment module 5114 then updates the bet database 5120 by using the average calculated in step 5406. For example, if the wager was for the Patriots to gain over 8 yards on the next play, but the calculated averages determine that it is more likely the Patriots will likely gain 10 yards on the next play, the bet database would be updated to change the wager from 8 yards to 10 yards prior to sending the wager to the user while keeping the odds the same. This example is similar to moving a “line” in an American football game. Also, the actual odds may adjusted using the same example, if it is more likely that the Patriots will gain 10 yards on the next play instead of the 8 yards in the wager, the odds for selecting over 8 yards may change from −105 to −250 and the wager for under 8 yards would be adjusted from −115 to +150, at step 5410. It is then determined by the adjustment module 5114 if there are any remaining wager IDs in the potential results database 5118, at step 5412. If it is determined there are more remaining wager IDs then the next wager ID is selected and the process returns to 5104, at step 5414. If there is no more remaining wager IDs from the potential results database 118 then the process returns to the base module 5110, at step 5416.

FIG. 55 displays the historic database 5116 which contains all the physiological data collected from participants of previous live events. The historic database 5116 contains event data, which is information about the event at that specific period of time in the event such as which team the physiological data was collected for, the player or participant the physiological data was collected for, what position the player plays or is aligned for the specific play, the quarter or period of time in the event the data was collected, the down and distance to go and the results of the play, for example gained 12 yards. The database also contains the physiological data collected during the play such as the player's heart rate, respiratory rate, body temperature, blood pressure, etc. In some embodiments, the physiological data may include the player's age, height, weight, body mass index (BMI), and may use calculations on the collected data to determine player's stamina, strength, speed, etc. in real time to get accurate projections of the player's capabilities on the upcoming players.

FIG. 56 displays the potential results database 5118 which stores the extracted corresponding data to a player's physiological data when the data is considered highly correlated along with the wager ID in order to determine if the averages of the extracted data for the players on the field are above or below the data for the wager in the bet database and are updated appropriately using the collected data. The database may contain the wager ID and the player, and the yards gained.

FIG. 57 displays the bet database 5120 containing a list of all current wagers available to the users of the server 5108. The bet database 5120 may contain wager data such as the wager ID, a description of the wager, and the wager odds. The bet database 5120 may contain event data related to the wager such as the team, the quarter or time period for the upcoming play, the down, and the distance to gain.

FIG. 58 displays an example of the odds update module 5112 and the resulting correlations. In the example for Figure A the data that is filtered by the event data and finding the various correlations with the physiological data and yards gained for quarterbacks, for example temperature, blood pressure, etc. An example of non-correlated data with the event data and the physiological data for quarterbacks would be yards gained and a quarterback's body temperature with a 15% (which is below the 90% threshold), therefore there is no correlation and no data should be extracted from the historic database and stored in the potential results database. Figure B displays an example of the correlations run in the odds update module 5112. In this example the data that is filtered by the event data from the bet database and finding the various correlations between the physiological data filtered on similar event data and the position of the participants which in this example are quarterbacks. The highest correlated physiological data with similar event data was the yards gained and heart rate with a 95% correlation (which is above the 90% threshold). Then the corresponding data related to the selected participant, in this example Tom Brady, is extracted. So, Tom Brady had a heart rate of 96 and the corresponding data, for yards gained, would be 15 yards. This data is extracted and stored in the potential results database. This process is continued for the remaining physiological data, and then is performed for every player on the field and all the extracted data is stored in the potential results database. Once in the potential results database the adjustment module calculates the average of the extracted data, in this example the yards gained, in order to update the bet database to change the current odds offered or adjust the actual wager.

FIG. 59 illustrates a system for an artificial intelligence based live game wager system, according to an embodiment.

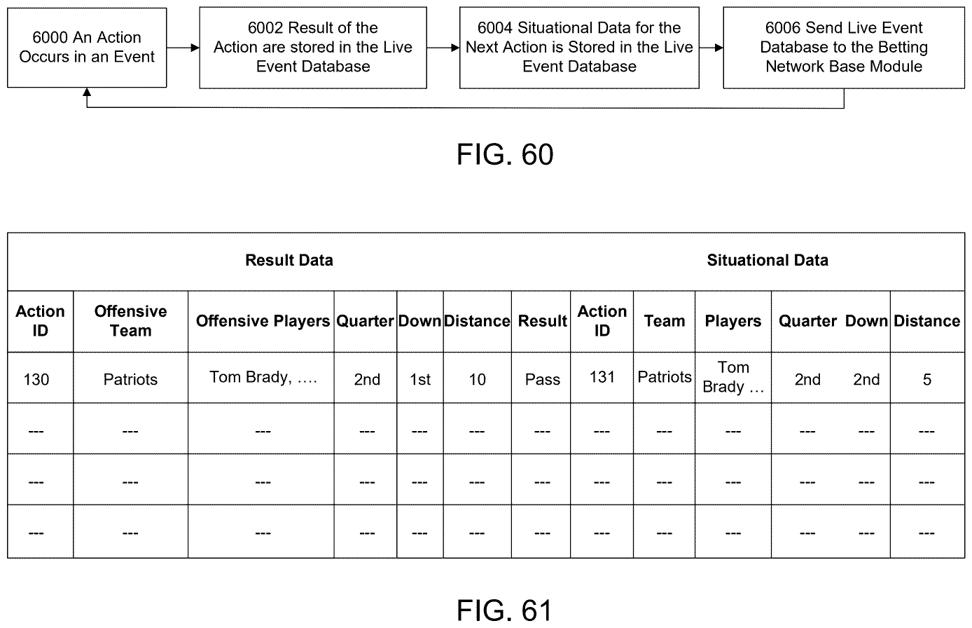

FIG. 60 illustrates a live event module, according to an embodiment.

FIG. 61 illustrates a live event database, according to an embodiment.

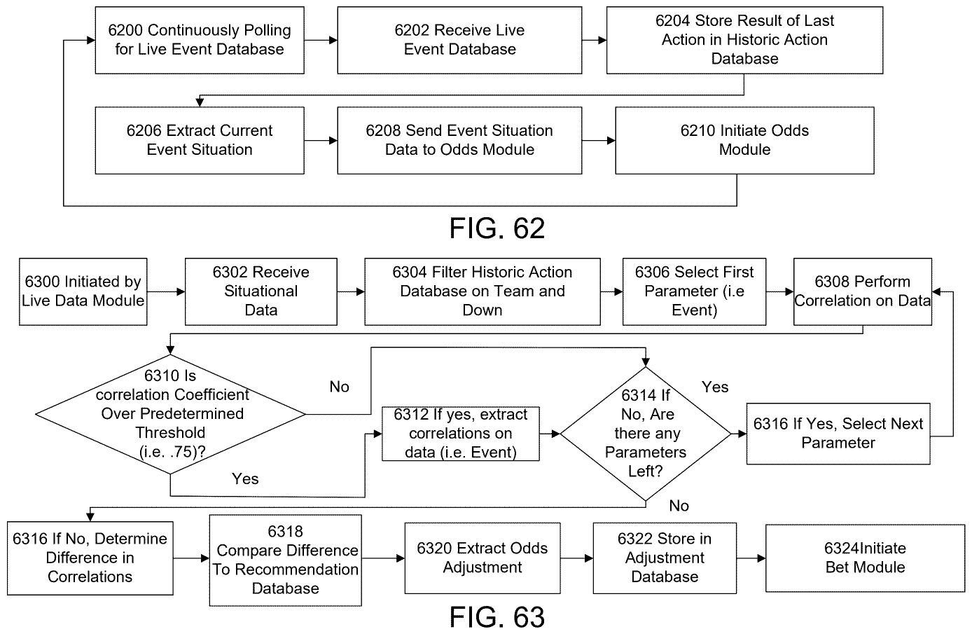

FIG. 62 illustrates a base module, according to an embodiment.

FIG. 63 illustrates an odds module, according to an embodiment.

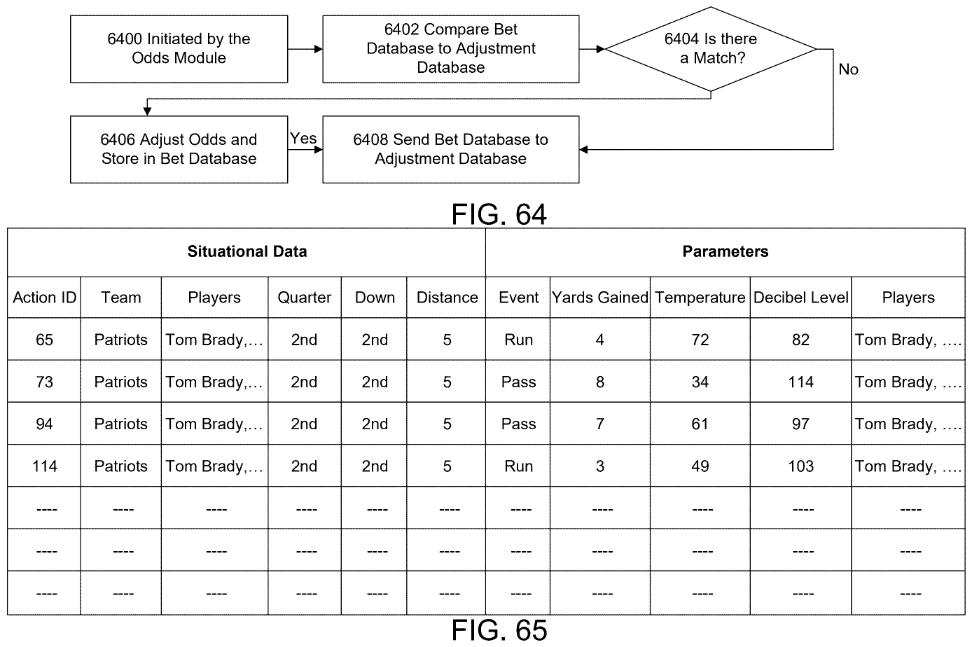

FIG. 64 illustrates a bet module, according to an embodiment.

FIG. 65 illustrates a historic action database, according to an embodiment.

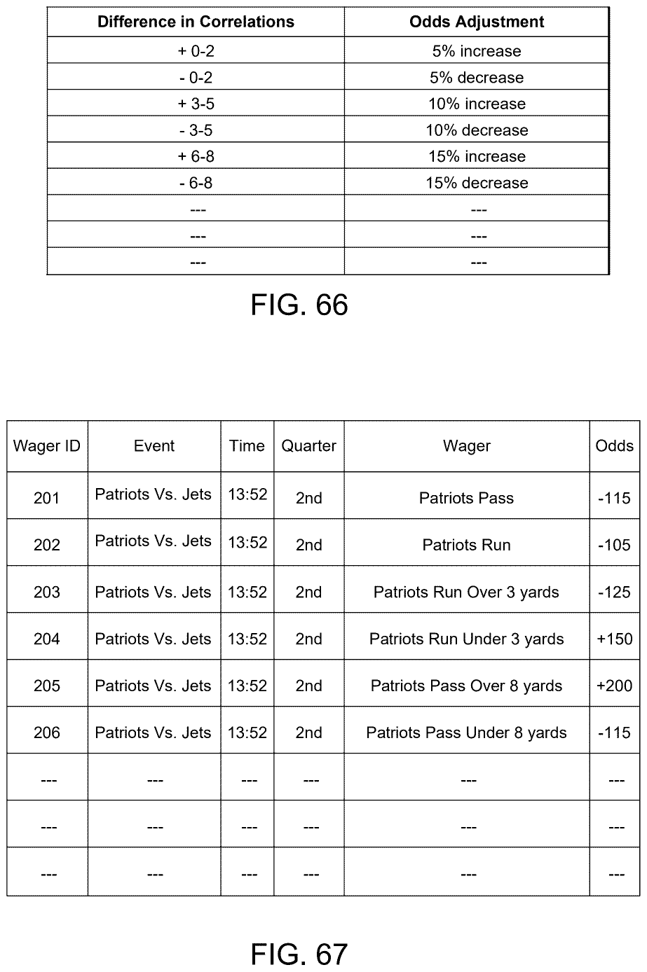

FIG. 66 illustrates a recommendation database, according to an embodiment.

FIG. 67 illustrates a bet database, according to an embodiment.

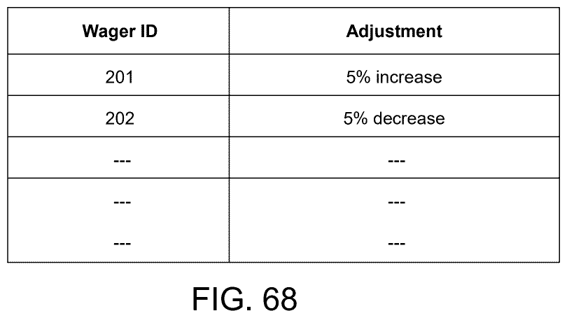

FIG. 68 illustrates an adjustment database, according to an embodiment.

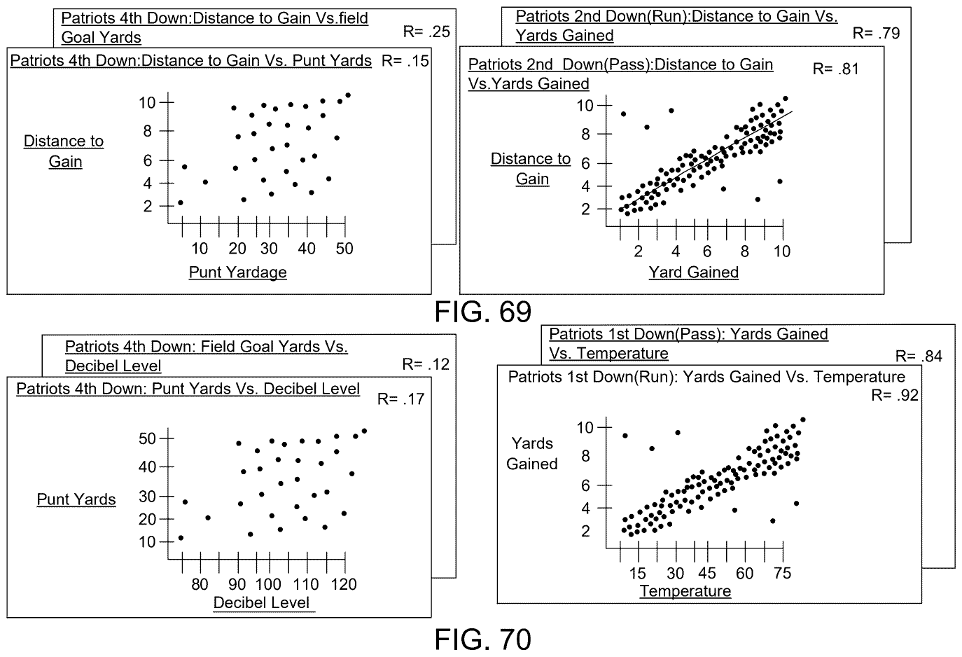

FIG. 69A illustrates an example of an odds module, according to an embodiment.

FIG. 69B illustrates an example of an odds module, according to an embodiment.

FIG. 70A illustrates another example of an odds module, according to an embodiment.

FIG. 70B illustrates another example of an odds module, according to an embodiment.

FIG. 59 displays a system for an artificial intelligence based live game wager system. This system includes a live event 5902, for example a sporting event such as a football game, basketball game, baseball game, hockey game, tennis match, golf tournament, etc. The live event 5902 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 5902, such as the score of American football or the run line in baseball, or a series of action in the live event 5902. Sportsbooks have an amount of bets they can handle, a limit of wagers they can take on either side of a bet before they will move the line or odds off of the opening line. Additionally, there are circumstances, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event 5902 or at another location. A live action input module 5904 that receives data about each individual action in a game or match and stores the data in the live event database 5906 which is sent to the betting network base module 5924. In some embodiments, an action may be a specific play or specific event in a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, to name a few. A live event database 5906, which stores data collected by the live event module 5904 such as the results of the action that has just occurred as well as the situational data for the next upcoming action. A cloud 5908 or communication network which may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, and other communication techniques known in the art. The communication network may allow ubiquitous access to shared pools of configurable system resources and higher-level services that can be rapidly provisioned with minimal management effort, often over internet and relies on sharing of resources to achieve coherence and economics of scale, like a public utility, while third-party clouds enable organizations to focus on their core businesses instead of expending resources on computer infrastructure and maintenance. A live event data API 5910, or application program interface, for delivering data from the live event 5902 to the betting network 5922. A user device API 5912, or application program interface, for delivering data between the betting network 5922 and the user device 5914. A user device 5914 for connecting to the cloud or internet and running the game app 5916. A user device 5914 may be a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device 5914 can leverage the sensors in for purposes such as automatic content recognition, augmented reality or the synchronization of screens between the user device 5914 interface and other displays. A game app 5916 that displays the odds for the next action of the live game, allows the user to place a bet, and displays the user's credits. A bet GUI 5918, or guided user interface or graphical user interface, that displays the possible betting options and odds for each betting option, the odds determine the ratio of credits bet to credits won or credits lost depending on the outcome of the wager. The interface(s) may either accept inputs from users or provide outputs to the users or may perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, virtual reality, augmented reality, eye tracking, or a combination of the above. Further, the interface(s) may either be implemented as a command line interface (CLI), a graphical user interface (GUI), a voice interface, or a web-based user-interface. A credits GUI 5920, or guided user interface, that display's the user's current amount of credits in the credit database, winning bets will increase the user's amount of credits while losing bets will decrease the user's amount of credits, credits may be tied to a real money value. A betting network 5922 which provides an artificial intelligence based software module that compares data from the live event 5902 to data in a historic action database 5930 in order to calculate odds of the next action in the live game in order to optimize the amount of bets from the users. A betting network 5922 may be located on a server which may perform real time analysis on the type of play and the result of a play or action. The server, or cloud, may also be synchronized with game situational data, such as the time of the game, the score, location on the field, weather conditions, and the like which may affect the choice of play utilized. For example, in other exemplary embodiments, server may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. The server can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user. A base module 5924 which receives the live event database 5906 from the live event module 5904, which contains historical and situational data on a live event 5902 currently occurring. The base module 5924 stores the historical data in the historic action database 5930 and sends the situational data to the odds module 5926 and initiates the odds module 5926. An odds module 5926 which uses the situational data from the live event 5902 to filter the historic action database 5930 on previous actions with some the same situational data and performs correlations on the similar actions in order to determine the difference in the correlations and compare the difference in correlations to the recommendation database 5932 in order to adjust the wager odds within the bet database 5934 accordingly. A bet module which compares the bet database 5934 to the adjustment database 5936 in order to determine if there is a match in the wager IDs, if there is a match then the wager odds are adjusted accordingly. A historic action database 5930 which stores all the historic actions of an event. A recommendation database 5932 which is used to determine the appropriate adjustment in the wager odds by using the difference in the correlated data from the odds module 5926. A bet database 5934 which contains the current options that users can place a wager on. An adjustment database 5936 which stores the wager ID and the appropriate adjustment, for example increase by 5% or decrease by 5%, needed for the specific wager.

FIG. 60 displays the live event module 5904. The process begins with an action, for example a play, occurs in an event, such as a sporting event, at step 6000. The live event module 5904 then stores the results of the action in the live event database 5906, at step 6002. The live event module 5904 also stores situational data in the live event database 5906 which is information for the upcoming action in an event, at step 6004. The live event module 5904 then sends the live event database 5906 to the betting network base module and the process returns to step 6000, at step 6006.

FIG. 61 displays the live event database 5906 which contains information on the live event 5902 such as results of the last action and information for the upcoming action. The live event database 5906 may contain result data such as the action ID, offensive team, offensive players, quarter or time period of the event, down, distance and result of the action such as a pass. In some embodiments, the result data may contain statistical information for offensive, defensive teams, or special teams, players, or coaches. The live event database 5906 also contains situational data or information for the upcoming action in a live event 5902. The situational data may include the action ID, offensive team, offensive players, quarter or time period of the event, down and distance. In some embodiments, the live event database 5906 may contain information regarding the defensive team or players, individual coaches, location of the event, temperature, levels of precipitation, type of precipitation, time of the event, referees or officials of the event, color of the uniforms for each team. In some embodiments the live event database 5906 may be a “sportsbook”, “casino”, “racino”, or “kiosk”.

FIG. 62 displays the base module 5924. The process begins with the base module 5924 continuously polling for the live event database 5906 from the live event module 5904, at step 6200. The base module 5924 receives the live event database 5906, at step 6202. The base module 5924 stores the results data, or the results of the last action, in the historic action database 5930 which contains historical data of all previous actions, at step 6202. The situational data from the live event database 5906 is extracted, at step 6204. The extracted situational data from the live event database 5906 is sent to the odds module, at step 6206. The odds module 5926 is initiated, and the process returns to continuously polling for the live event database 5906, at step 6206.

FIG. 63 displays the odds module 5926. The process begins with the odds module 5926 being initiated by the base module 5924, at step 6300. The odds module 5926 receives the situational data, or information about the upcoming action or action in an event, from the base module 5924, at step 6302. The odds module 5926 filters the historic action database 5930 on the team and down from the situational data, at step 6304. The first parameter of the historic action database 5930 is selected, for example the event, at step 6306. Then the odds module 5926 performs correlations on the data. For example, the historical action database 5930 is filtered on the team, the players, the quarter, the down and the distance to be gained. The first parameter is selected which in this example is the event, which may either be a pass, or a run and the historical action database 5930 is filtered on the event being a pass. Then, correlations are performed on the rest of the parameters, which are yards gained, temperature, decibel level, etc. In FIG. 69B the graph shows the correlated data for the historical data involving the Patriots in the second quarter on second down with five yards to go and the action being a pass, which has a correlation coefficient of 0.81. The correlations are also performed with the same filters and the next event which is the action being a run which is also shown in FIG. 69B and has a correlation coefficient of 0.79, at step 6308. It is determined if the correlation coefficient is above a predetermined threshold, for example 0.75, in order to determine if the data is highly correlated and deemed a relevant correlation, at step 6310. If the correlation is deemed highly relevant, then the correlation coefficient is extracted from the date. For example, the two correlation coefficients of 0.81 for a pass and 0.79 for a run are both extracted, at step 6312. If it is determined that the correlations are not highly relevant, then then it is determined if there are any parameters remaining. Also, if the correlations were determined to be highly relevant therefor extracted It is also determined if there are any parameters remaining to perform correlations on, at step 6314. If there are additional parameters to have correlations performed then the odds module 5926 selects the next parameter in the historic action database and returns to step 6308, at step 6316. Once there are no more remaining parameters to perform correlations on, the odds module 5926 then determines the difference between each of the extracted correlations. For example, the correlation coefficient for a pass is 0.81 and the correlation coefficient for a run is 0.79. The difference between the two correlation coefficients (0.81-0.79) is 0.02. In some embodiments, the difference may be calculated by using subtraction on the two correlation coefficients. In some embodiments, the two correlation coefficients may be compared by determining the statistical significance. The statistical significance can be determined by using the following formula: Zobserved=(z1−z2)/(square root of [(1/N1−3)+(1/N2-3)], at step 6316. The difference between the two correlation coefficients, 0.02, is then compared to the recommendation database 5932. The recommendation database 5932 contains various ranges of differences in correlations as well as the corresponding odds adjustment for those ranges. For example, the 0.02 difference of the two correlation coefficients falls into the range +0-2 difference in correlations which according to the recommendation database 5932 should have an odds adjustment of 5% increase, at step 6318. The odds module 5926 then extracts the odds adjustment from the recommendation database 5932, at step 6320. The extracted odds adjustment is stored in the adjustment database 5936, at step 6322. Then odds module 5926 initiates the bet module, at step 6324.

In some embodiments external factors, such as time of day, weather, etc., generally non-gameplay data as opposed to gameplay data that is directly related to action or plays in a live sporting event, are sufficiently correlated with particular outcomes to adjust the odds in this way. For example, in American football, when it is actively snowing the offensive team is more likely to run the ball as opposed to pass. How much more a given team is to favor running over passing in the snow is dependent upon a number of other factors, such as the quarterback's history of handling the ball in cold weather, the offensive system run by that team, which may make the transition to a run heave offensive game plan more or less difficult. Time of day can also have an impact on specific outcomes. For example, in baseball games played in the afternoon there are periods during the game in which the pitcher is in the sun and the batter is in the shade. This may decrease the batter's ability to pick up the pitch type/spin pattern out of the pitcher's hand, making these conditions more correlated with a swing and miss as opposed to hitting the ball in play. In another example the individual player's performance may be correlated with a particular outcome type. For example, certain quarterbacks in the NFL have a greater drop off in their performance when the temperature declines as they have trouble gripping the football, and thus making throws that are as accurate as they would make in warmer weather. A pitcher in baseball may have a similar performance variance as temperature and humidity change the texture of the leather on the baseball and impact how good of a grip the pitcher can get on the ball. This will impact the spin rate of the pitch, with spin rate declining as the tackiness of the baseball declines. This weather factor will have a varying impacts on different pitchers and may have different impacts on different pitch types thrown by an individual pitcher. For example, a split-finger fastball has significantly more drop when the pitcher has a good grip. If the pitcher cannot get the same amount of drop on this pitch it is more likely the hitter will have success. Comparatively a four-seam fastball is less dependent upon spin rate to be a successful pitch. In that example this may impact the odds of different pitch types, with the odds of the pitcher throwing the four-seam fastball may increase while the odds of that same pitcher throwing their split-finger fastball may decrease. In any of these embodiments, the non-gameplay data may be displayed so that a user can better understand changes in odds or tailor their wager or wagers based on the non-gameplay data. For example, during an American football game where it is snowing, a wagering interface may display information, such as an icon or graphic, indicating it is snowing during the game, along with related intensity data, temperature data, wind data, and the like.

In still other exemplary embodiments, other factors may be utilized as non-gameplay data. Such factors include location data, such as the geographical location of stadium, arena, field of play, or the like, altitude data of the geographical location, and other factors that can affect ambient conditions of gameplay or performance in a game or live event 5902.

FIG. 64 displays the bet module 5934. The process begins with the bet module being initiated by the odds module, at step 6400. The bet module compares the bet database to the adjustment database 5936, at step 6402. It is determined if there is a match in any of the wager ID's in the bet database 5934 and the adjustment database 5936. For example, the bet database 5934 contains a list of the all the current bet options for a user which for each bet option the bet database 5934 contains a wager ID, event, time, quarter, wager, and odds. The adjustment database 5936 contains the wager ID and the percentage, either an increase or decrease, the odds should be adjusted. If there is a match between the bet database 5934 and the adjustment database 5936, then the odds in the bet database 5934 are adjusted by percentage increase or decrease in the adjustment database 5936 and the odds in the bet database 5934 is updated. For example, if the odds in the bet database 5934 are −105 and the matched wager ID in the adjustment database 5936 is a 5% increase then the updated odds in the bet database 5934 should be −110, at step 6404. If there is a match then the odds are adjusted based on the data stored in the adjustment database 5936 and the new data is stored in the bet database 5934 over the old entry, at step 6406. If there are no matches, or once the bet database 5934 has been adjusted if there are matches, the bet module sends the bet database 5934 to the user device 5914 allowing users to place bets on the wagers stored in the bet database 5934, at step 6408.

FIG. 65 displays the historic action database 5930, which is created via the base module 5924 storing the results from the live event database 5906. The historic action database 5930 contains situational data such as the action ID, the team, the players, the quarter, the down, and the distance. The historic action database 5930 also contains parameters such as the event, yards gained, temperature, decibel level, and players. It should be noted that this database, as currently constructed, is used for the purpose of a working example for football and the current disclosure and should not be viewed as limiting. The historic action database 5930 may contain situational data and parameters for various events or sporting events such as football, basketball, baseball, hockey, soccer, rugby, golf, tennis, etc. The situational data is information about actions such as the statistical information for teams or individuals competing in an event, the time period of the event, and information leading up to the upcoming action, for example, in the current lead or deficit for a team or player, the location of a certain player or players on the event field, court, or pitch, etc. In some embodiments, the situational data may be information related to sensor data related to individual players, teams, or sensor data retrieve from wearable devices or equipment such as balls, protective equipment, clubs, bats, etc. The parameters would be the information containing the results of the situational data which would be the statistical data that resulted from the action related to the situational data, in FIG. 65.

FIG. 66 displays the recommendations database 5932 which is used in the odds module 5926 to determine how the wager odds should be adjusted depending on the difference between the correlation coefficients of the correlated data points. The recommendations database 5932 may contain the difference in correlations and the odds adjustment. In some embodiments, the difference in correlations may be the statistical significance of comparing the two correlation coefficients in order to determine how the odds should be adjusted.

FIG. 67 displays the bet database 5934 that contains the potential bets or wagers that users can place on the event and is updated via the odds module 5926 and the bet module depending on the resulting correlation coefficients. The bet database 5934 contains the wager ID, the event, the time, the quarter, the wager, and the odds. It should be noted that the bet database 5934 is currently constructed to provide a working example using football as the event, but the bet database 5934 would be constructed based on a sport by sport basis. Other examples of bet data stored in the bet database 5934 may be “wager”, “buy points”, “price”, “no action”, “sides”, “longshot”, “opening line”, “favorite”, “chalk”, “circled game”, “laying the points price”, “dog”, “underdog”, “money line”, “straight bet”, “straight-up”, “line”, “cover the spread”, “cover”, “tie”, “pick”, “pick-cm”, “middle”, “parlay”, “round robin”, “teaser”, “prop bet”, “first-half-bet”, “half-time-bet”, “listed pitchers”, “run line”, “futures bet”, “future”, “handle”, “juice”, “vigorish”, “off the board” or “customized betting”. In some embodiments, the data in the bet database 5934 may be received or sent to “sportsbooks”, “casinos”, “racinos”, or “kiosks”.

FIG. 68 displays the adjustment database 5936 is used to adjust the wager odds of the bet database 5934, if it is determined that a wager should be adjusted. The adjustment database 5936 contains the wager ID, which is used to match with the bet database 5934 to adjust the odds of the correct wager.

FIGS. 69A and 69B displays an example of the odds module 5926 and the resulting correlations. FIG. 69A: In this example the data that is filtered by the team, down and quarter and finding the various correlations with the team, down and quarter and the various parameters such as the yards to gain, punt yardage, field goal yardage, etc. An example of non-correlated parameters with the team, down, and quarter and the yards to gain and punt yardage with a 15% (which is below the 75% threshold), therefore there is no correlation and the next parameters should be correlated, unless there are no more parameters remaining. FIG. 69B: In this example the data that is filtered by the team, down and quarter and finding the various correlations with the team, down and quarter and the various parameters such as the event, yards to gain, yards gained, etc. An example of correlated parameters is with the event being a pass and the team, down, and quarter with an 81%, therefore there is a correlation (since it is above the 75% threshold) and the correlation coefficient needs to be extracted and compared with the other extracted correlation coefficient which in this example is the event data where the event is a run, which is correlated at 79%. The difference of the two correlations are compared to the recommendations database 5932 in order to determine if there is a need to adjust the odds. In this example, there is a 0.02 difference between the event being a pass and the event being a run, which means on second down in the second quarter the New England Patriots are slightly more likely to throw a pass than to run the ball and the odds are adjusted 5% decrease in order to match the correlated data. Conversely, if the correlated data of run, 0.79 is compared to the correlated data of a pass, 0.81, then the difference would be −0.02 and the odds would be adjusted by 5% increase.

FIGS. 70A and 70B displays another example of the odds module 5926 and the resulting correlations. FIG. 70A: In this example the data that is filtered by the team, down and quarter and finding the various correlations with the team, down and quarter and the various parameters such as the decibel level in the stadium, punt yardage, field goal yardage, etc. An example of non-correlated parameters with the team, down, and quarter and the decibel level in the stadium and punt yardage with a 17% (which is below the 75% threshold), therefore there is no correlation and the next parameters should be correlated, unless there are no more parameters remaining. FIG. 70B: In this example the data that is filtered by the team, down and quarter and finding the various correlations with the team, down and quarter and the various parameters such as the event, temperature, yards gained, etc. An example of correlated parameters is with the event being a run and the team, down, and quarter with an 92%, therefore there is a correlation (since it is above the 75% threshold) and the correlation coefficient needs to be extracted and compared with the other extracted correlation coefficient which in this example is the event data where the event is a pass, which is correlated at 84%. The difference of the two correlations are compared to the recommendations database 5932 in order to determine if there is a need to adjust the odds. In this example, there is a 0.08 difference between the event being a run and the event being a pass, which means on first down in the first quarter the New England Patriots are more likely to throw a run than to pass the ball and the odds are adjusted 15% decrease in order to match the correlated data. Conversely, if the correlated data of run, 0.84 is compared to the correlated data of a pass, 0.92, then the difference would be −0.08 and the odds would be adjusted by 15% increase.

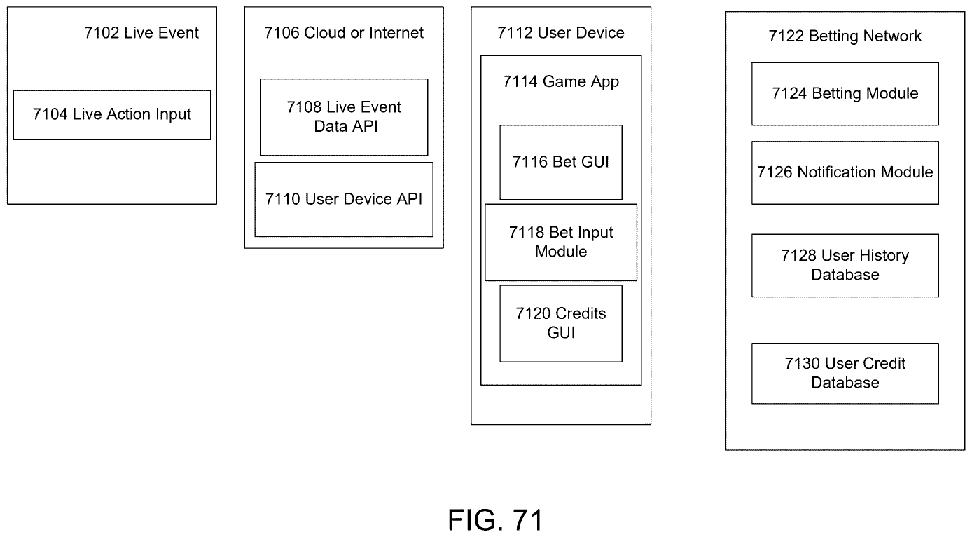

FIG. 71 Illustrates a Real Time Action of Interest Notification System, according to an embodiment.

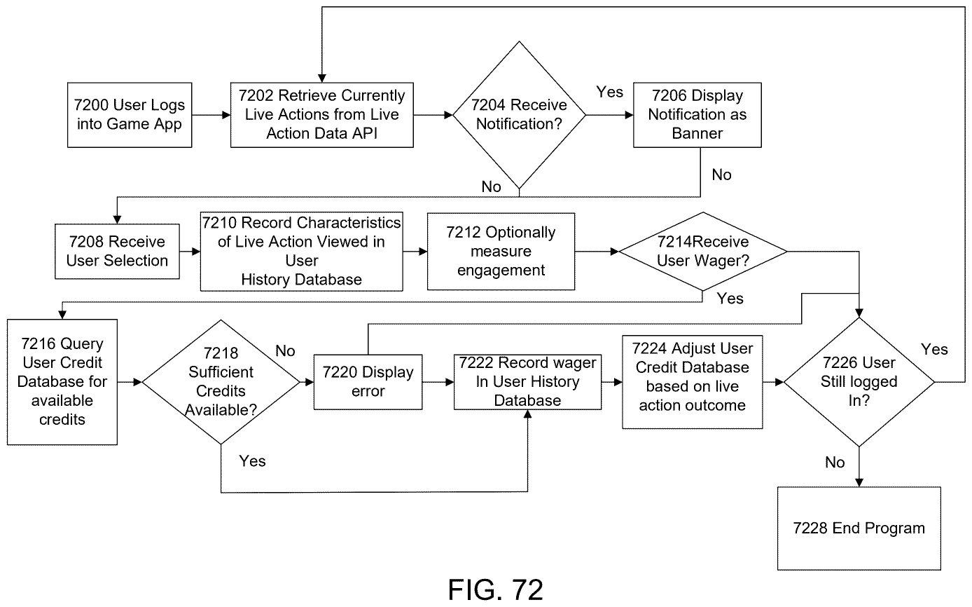

FIG. 72 Illustrates a Betting Module, according to an embodiment.

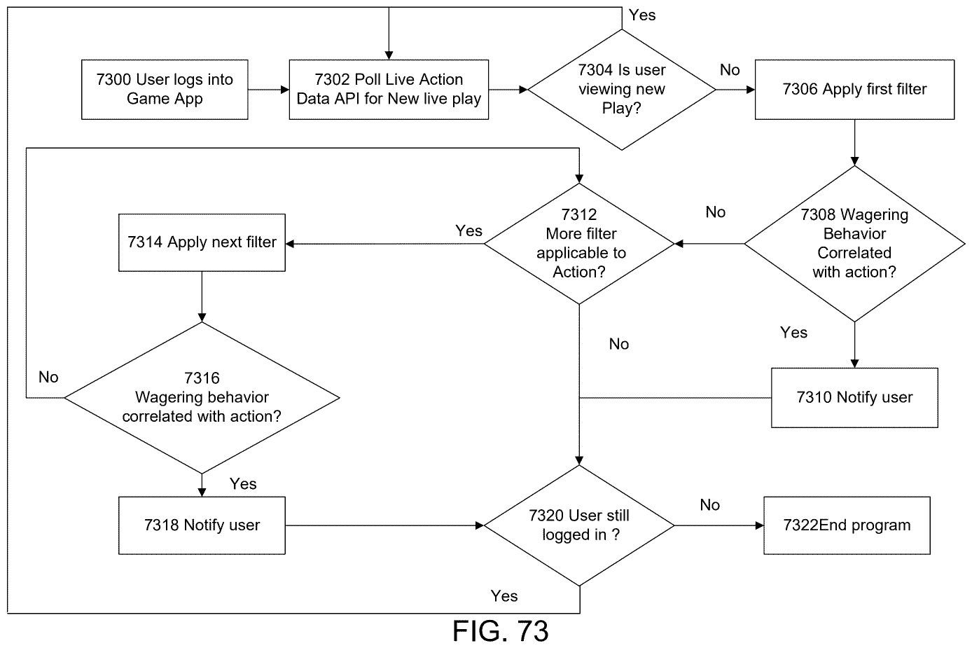

FIG. 73 Illustrates a Notification Module, according to an embodiment.

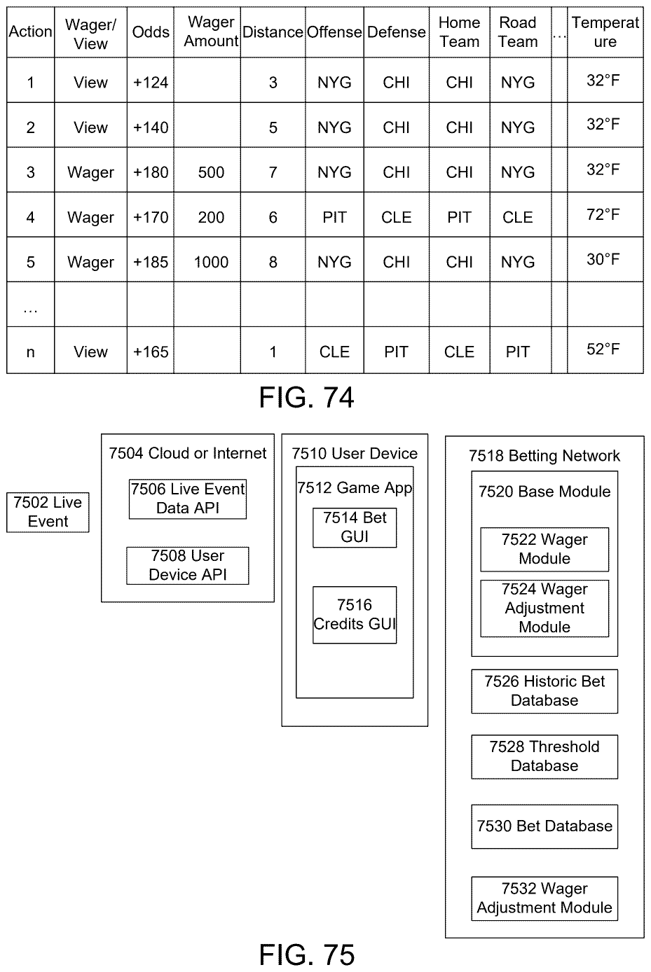

FIG. 74 Illustrates a User History Database, according to an embodiment.

FIG. 71 displays a system for a real time action of interest notification system. This system includes at least two live games, for example a sporting event such as a football game, basketball game, baseball game, hockey game, tennis match, golf tournament, etc. The live event will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event, such as the score of American football or the run line in baseball, or a series of action in the live event. Sportsbooks have an amount of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event or at another location, in element 7102. A live action input module that receives data about each individual action in the game, for example which players were involved in an action during a sporting event. In some embodiments, an action may be a specific play or specific event in a sporting event. In some embodiments, an action may be a throw, shot, pass, swing, kick, hit, performed by a participant in a sporting event. In some embodiments, an action may be a strategic decision made by a participant in the sporting event such as a player, coach, management, etc. In some embodiments, an action may be a penalty, foul, or type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, in element 7104. This system may also include a cloud or communication network which may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, and other communication techniques known in the art, in element 7106. Included in the system may be an API for delivering data from the live game 7102 to the betting network, in element 7108. Also, an API for delivering data between the betting network and the user device may be included within the system, in element 7110. The system may also include a user device for connecting to the cloud or internet and running the game app. A user device may be a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device can leverage the sensors in for purposes such as automatic content recognition, augmented reality or the synchronization of screens between the user device interface and other displays, in element 7112. Included in the system may be a game app that displays the odds for the next action of the live game 7102, allows the user to place a bet, and displays the user's credits, in element 7114. The system may include a bet GUI that displays the possible betting options and odds for each betting option, the odds determine the ratio of credits bet to credits returned if the bet was correct, in element 7116. Included in the system may be a bet input module that allows the user to choose to bet credits on one or more options, in element 7118. The system may include a credits GUI that display's the user's current amount of credits in the credit database, which may increase or decrease and may be tied to a real money value or to a point system, in element 7120. The system may include a betting network which provides an artificial intelligence-based software module that monitors the user's history of viewing and making wagers through the game app in order to identify actions that are highly correlated with actions the user has previously viewed or wagered on. The betting network may be located on a server which may perform real time analysis on the type of play and the result of a play or action. The server, or cloud, may also be synchronized with game situational data, such as the time of the game, the score, location on the field, weather conditions, and the like which may affect the choice of play utilized. For example, in other exemplary embodiments, server may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. The server can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user, in element 7122. The system may include a betting module that allows the user to view available live actions to wager on, select those actions that interest them and wager credits or funds available to them in element 7124. The system may include a notification module that monitors live actions available to be wagered on, then compares characteristics of those available live actions to actions the user has previously viewed or wagered on in the past, such as a third down and between 7 and 10 yards to go for a first down involving the New York Giants on the road, and deliver a notification through the game app that such an action is available to be wagered upon. In some embodiments, a user may select potential wager options of interest that they can be notified about when the wager option is available. In some embodiments, the notification may be a push notification, text message, e-mail, banner notification, voice message, or the like, in the event the user in not currently in the game app or is not logged into the game app, in element 7126. The system may also include a user history database that houses the characteristics of all actions the user has either viewed or wagered on in element 7128. Also, the system may include a user credit database that houses the credits or funds the user has available to wager in element 7130.

FIG. 72 displays the betting module 7124. The process begins with user logging into the game app on their device, at step 7200. The betting module retrieves from the live action data API 7108 all the available live actions available and the odds available on them, that are calculated in the manner described in US20190197836 “Method, System and Computer Program Product for Sports Game”, which is incorporated by reference herein its entirety, by receiving the results of a first play and comparing the play results to a plurality of predetermined factors to determine if the play is complete and determining wagers based on the first play result information and historical play information related to a plurality of factors in the play result information, at step 7202. Then the betting module is continuously polling the notification module for an available live action that is correlated with the present user's history, at step 7204. If a notification is received, that action is displayed as a banner notification across the top of the game app's present user interface screen, at step 7206. The betting module receives the user's selected available live action to potentially wager on, at step 7208. The betting module records the characteristics of the action being viewed, such as down and distance, teams involved, location, weather, etc., in the user history database, at step 7210. In this embodiment the system measures wagers viewed and wagers made, a wager made may be considered more indicative of future behavior, for example five times more, than a wager viewed. However, there are many ways known in the art to measure a user's engagement with content on a device such as a smartphone or tablet. One or more of these methods, such as time on screen, eye gaze tracking, etc., could be used to score wagers viewed on a sliding scale between the one and five used in the present embodiment, at step 7212. It is then determined if the user wagered on the live play, if the user did not wager on the live play then the process proceeds to step 7226, at step 7214. If the user did select to wager on the live play, query the user credit database for the credits, or funds, available to the user, at step 7216. It is then determined by the betting module if there are sufficient credits or funds available to the user to make the selected wager, at step 7218. If the user does not have sufficient credits or funds available to them, display an error message that allows the user to change their wager amount or add credits or funds to their account at step 7220. If the user has sufficient credits or funds available to them, record the wager in the user history database at step 7222. The user's account balance is adjusted in the user credit database based on the outcome of the live action and the wager parameters, at step 7224. It is then determined if the user is still logged in to the game app, at step 7226. If the user is still logged in the process returns to step 7202, however if the user has logged out, the program ends, at step 7228. It should be noted that the betting module can be made available for access, reconfiguration, modification, or control for “customers” or used for “managed service user interface service”, “managed service risk management services”, “managed service compliance service”, “managed service pricing and trading service”, “managed service and technology platform”, “managed service and marketing support services”, “payment processing services”, “business applications”, “engaging promotions”, “customized betting”, “business applications”, “state based integration”, “game configurator”, “fantasy sports connector”, “software as a service”, “synchronization of screens”, “automatic content recognition (ACR)”, “joining social media”, “Augmented reality”, “digital gaming”, “Esports” or for user's to “cash out”.

FIG. 73 displays the notification module 7126. The process begins with the user logging into the game app on their user device at step 7300. The module then polls the live action data API 7104 for a new live action available to be wagered on at step 7302. It is then determined if the user is viewing the live action received from the live action data API 7104. This is done because the system prevents sending the user a notification to view an action that they are already viewing. In this scenario the module will return to step 7302, at step 7304. If the live action received is not being viewed by the user, a first filter is applied to the user's historical wagers made and wagers viewed in the user history database. In this embodiment the first filter is the distance from a first down for the offense in an American football game. In this exemplary embodiment regarding American football, it may be understood that an action may be a form of football play or other occurrence associated with an American football game. The live play received from the live action data API 7104 is a 3rd down with 7 yards to go for the New York Giants against the Chicago Bears in the third quarter of their game in Chicago in which the Bears are leading 10-7. The first filter applied in this example, to the user's data in the user history database is for actions with between 7 and 10 yards to go until first down at step 7306. The notification modules determines if the user has a wagering behavior in their history that is correlated with the filtered data. For example, the current live play is 7 yards to go for the first down. All plays with between 7 and 10 yards to go that the user either viewed and/or wagered on are retrieved from the user history database and the correlation between the odds on the current live play and the user's wagering/viewing history is calculated. The notification threshold may be a predetermined threshold, that may be determined by the operators of the betting network, which is correlating past wagers made and viewed by the user to the current play that is available to be wagered on. If the data points between the user's history and the current play, for example the distance to go, the down, the team involved, etc., are highly correlated and exceed the predetermined threshold the user will receive a notification about the current play and available wager. However, if the data points are not correlated and do not exceed the predetermined threshold the user will not receive a notification. The data points are correlated by calculating a correlation coefficient which represents the linear dependence of two variables or sets of data. The notification threshold may vary from filter to filter and user to user based on the sample size available and how sensitive the operators of the betting network determine the threshold. The operators of the betting network may set the notification threshold for notifying a user when only the distance filter is applied at a correlation coefficient of 0.90. For example, a user's history of wagers made, and wagers viewed shows a high correlation coefficient, 0.92 for actions where there are fifteen to twenty yards to go for a first down. The present play has between seven and ten yards to go for a first down, which is not highly correlated enough with the user's wagering history at step 7308. If the user's history is highly correlated with the current play and odds a notification is sent to the user at step 7310. The notification module then determines if there are more filters that can be applied, at step 7312. In this example, after the distance filter, of 7-10 yards, is applied first, the next filter would be applied, such as which down the play is occurring, for example 3rd down. Additional filters may be applied, for example which teams are involved in the play, such as the New York Giants, at step 7314. It is then determined if the user has a wagering behavior in their history that is correlated with the multiply filtered data. For example, the current live play is 7 yards to go for the first down. All 3rd down plays with between 7 and 10 yards to go that the user either viewed and/or wagered on are retrieved from the user history database and the correlation between the odds on the current live play and the user's wagering/viewing history is calculated. The user's wagering history shows a correlation coefficient of 0.81, which falls below the notification threshold of 0.85 for two filters. However, when the additional filter that includes games involving the New York Giants, is applied, the correlation coefficient goes to 0.82 which exceeds the notification threshold of 0.80 at step 7316. If the user's history is highly correlated with the current play and odds a notification is sent to the user. The threshold for notification is going to vary from filter to filter and user to user based on the sample size available and how sensitive the operators. The threshold for correlation will have to drop as more filters are applied as the sample size will decrease, so the operators may set the correlation coefficient threshold for two filters at 0.85, and three filters at 0.80 and four or more filters at 0.75. When the multiply filtered dataset exceeds the correlation coefficient threshold, the user is notified of the pending play at step 7318. The notification module then determines if the user is still logged into the game app at step 7320. If the user is still logged into the game app after at least two filters have been applied to the user history database, the notification module will return to step 7312. If there are more filters available, the module will return to step 7302, but if there are no more filters to apply and the user has logged out the program will end, at step 7322.

FIG. 74 displays the user history database 7128. The database contains one table for each registered user of the game app. That table collects data about each wager the user views and wagers on. That data includes but is not limited to, the teams involved, where the game is being played, the distance to go for a first down, what down it is, the odds, the weather, etc. This data is used to calculate correlations between the type of bet available and the user's wagering history. In this example a wager is counted as five instances of viewing a wager so as to give weight to both. In this fashion the wagers a user takes the time to view are still counted towards the types of wagers they are interested in, but wagers they actually gamble on are given significantly more weight. The five to one ratio is chosen as an example in this embodiment and the ratio would be determined by the system operators. Optionally the user's level of engagement with viewed but not gambled upon wagers can be measured so as to scale the value of wagers the user views based on their level of interest. For example, a wager the user strongly considered, as measured by engagement, could count for three views. In some embodiments, the user may be able to view the user history database and select past wagers or data points from previous wagers, such as the odds, team involved, etc., in order to be notified when these occur again. This may be accomplished by storing the user selections in a separate database and the each current live play would be compared to the database in order to determine if any of the fields are a match, for example the odds provided, the teams involved, the down, distance to gain, etc. If there is a match then a notification will be sent to the user in order to alert them of the available wager. Other examples of wager data can be a “bet”, “wager”, “buy points”, “price”, “no action”, “sides”, “longshot”, “opening line”, “favorite”, “chalk”, “circled game”, “laying the points price”, “dog”, “underdog”, “money line”, “straight bet”, “straight-up”, “line”, “cover the spread”, “cover”, “tie”, “pick”, “pick-em”, “middle”, “parlay”, “round robin”, “teaser”, “prop bet”, “first-half-bet”, “half-time-bet”, “listed pitchers”, “run line”, “futures bet”, “future”, “handle”, “juice”, “vigorish”, “off the board” or “customized betting”.

FIG. 75 illustrates an artificial intelligence based live game wager adjuster, according to an embodiment.

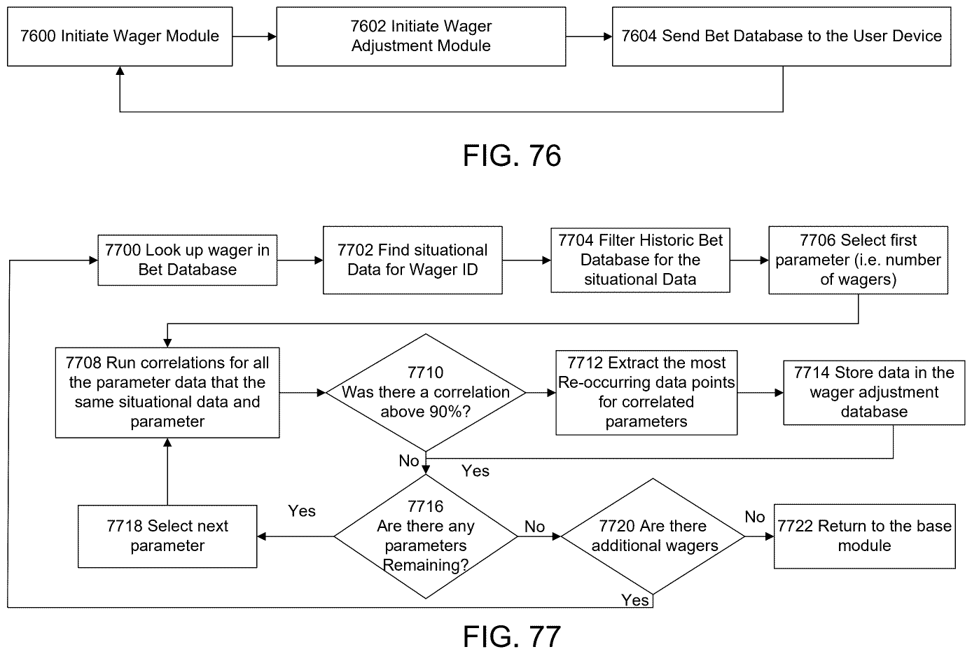

FIG. 76 illustrates a base module, according to an embodiment.

FIG. 77 illustrates a wager module, according to an embodiment.

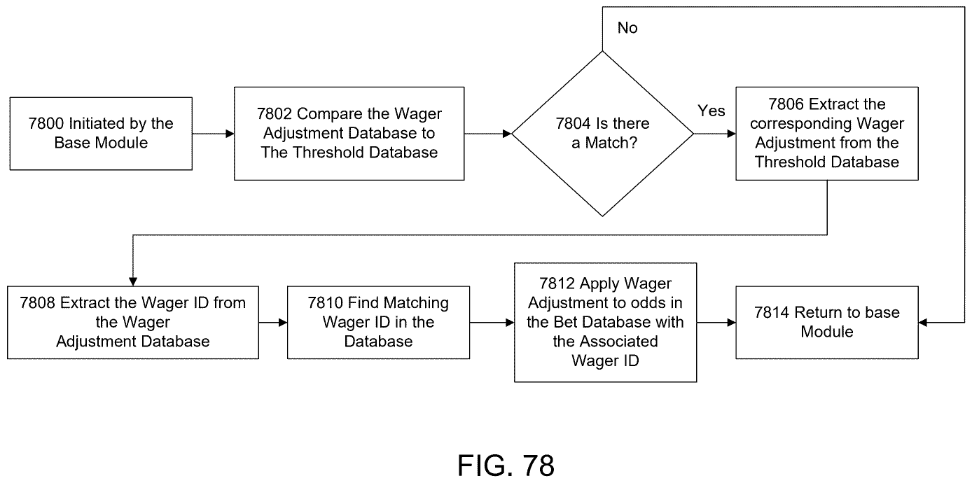

FIG. 78 illustrates a wager adjustment module, according to an embodiment.

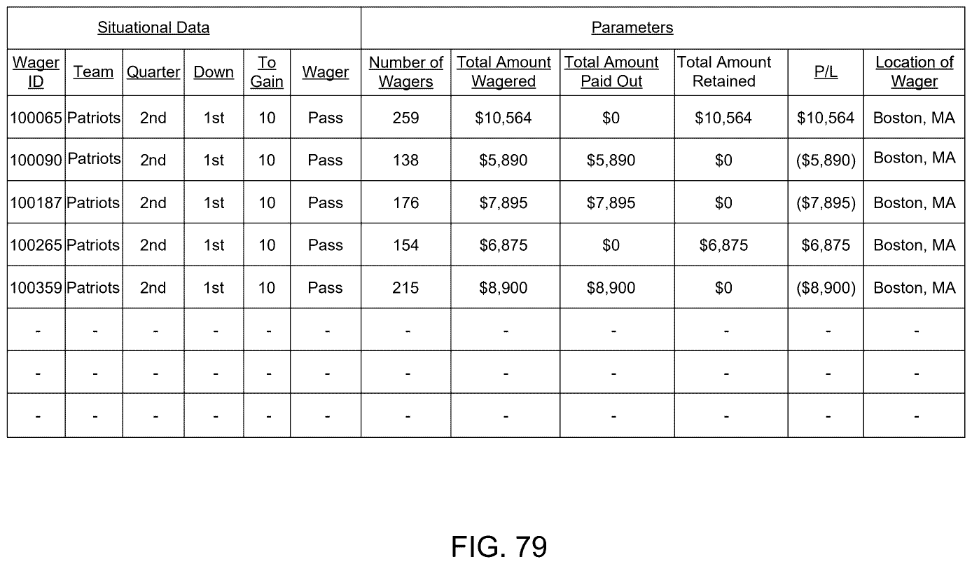

FIG. 79 illustrates a historic bet database, according to an embodiment.

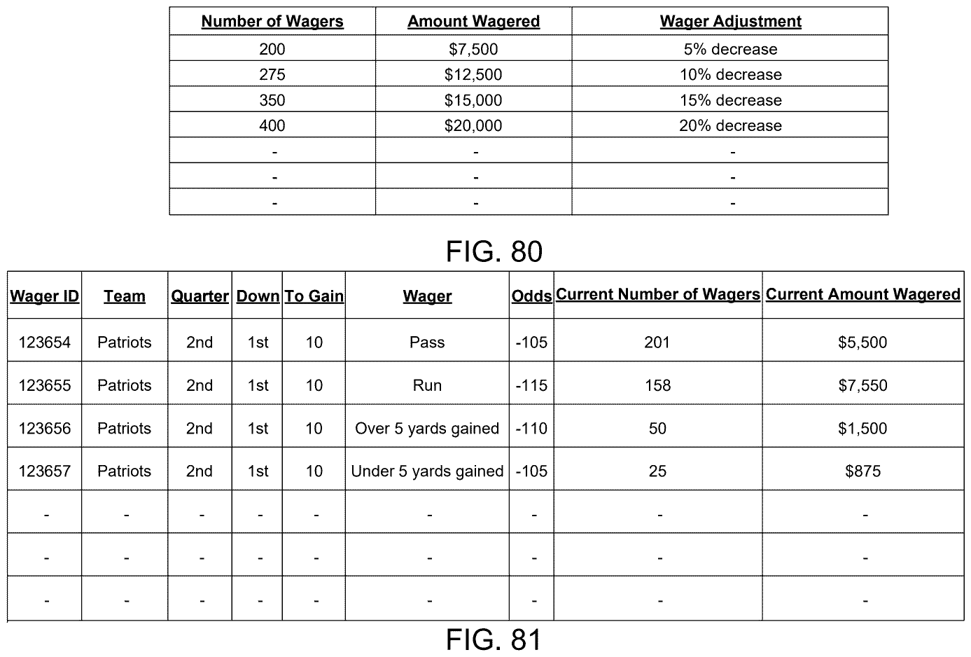

FIG. 80 illustrates a threshold database, according to an embodiment.

FIG. 81 illustrates a bet database, according to an embodiment.

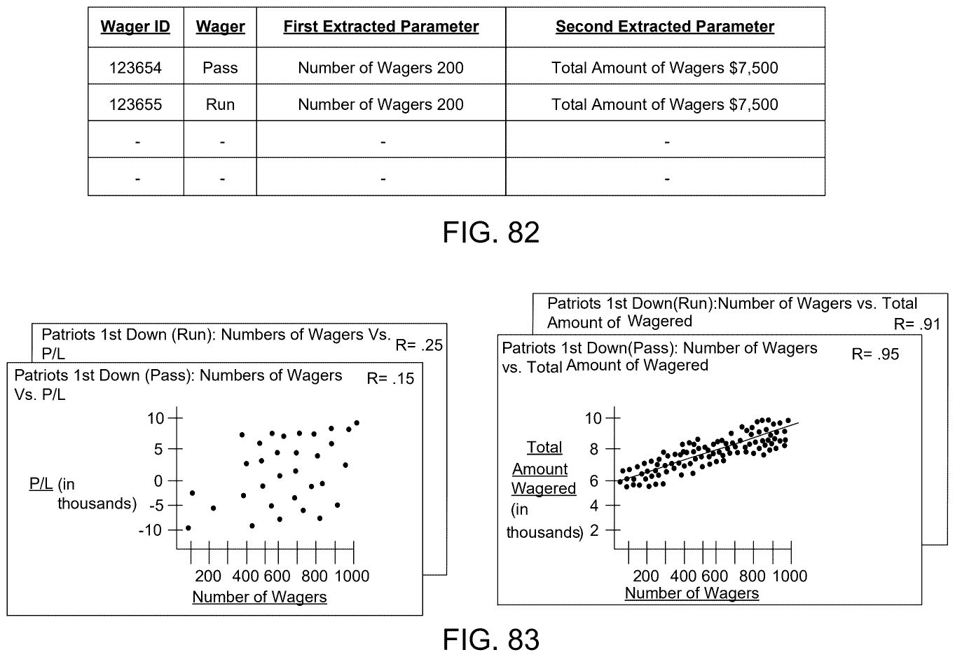

FIG. 82 illustrates a wager adjustment database, according to an embodiment.

FIG. 83A illustrates an example of a wager module, according to an embodiment.

FIG. 83B illustrates another example of a wager module, according to an embodiment.

FIG. 75 displays a system for an artificial intelligence based live game wager system. This system includes of live event 7502, for example a sporting event such as a football game, basketball game, baseball game, hockey game, tennis match, golf tournament, etc. The live event 7502 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 7502, such as the score of American football or the run line in baseball, or a series of action in the live event 7502. Sportsbooks have an amount of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event 7502 or at another location. A cloud 7504 or communication network which may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance. A live event data API 7506, or application program interface, for delivering data from the live event 7502 to the betting network 7518. A user device API 7508, or application program interface, for delivering data between the betting network and the user device 7510. A user device 7510 for connecting to the cloud or internet and running the game app 7512. A user device 7510 may include a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device 7510 can leverage the sensors in for purposes such as automatic content recognition, augmented reality or the synchronization of screens between the user device interface and other displays. A game app 7512 that displays the odds for the next action of the live game, allows the user to place a bet, and displays the user's credits. A bet GUI 7514, or guided user interface, that displays the possible betting options and odds for each betting option, the odds determine the ratio of credits bet to credits returned if the bet was correct. The interface(s) may either accept inputs from users or provide outputs to the users or may perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a command line interface (CLI), a graphical user interface (GUI), a voice interface, or a web-based user-interface. A credits GUI 7516, or guided user interface, that display's the user's current amount of credits in the credit database, winning bets may increase the user's amount of credits while losing bets may decrease the user's amount of credits, credits may be tied to a real money value. A betting network 7518 which provides an artificial intelligence based software module that finds correlations from the historic bet database 7526 in order to determine if the odds for the current wagers in the bet database need to be adjusted. The betting network may be located on server which may perform real time analysis on the type of play and the result of a play or action. The server, or cloud, may also be synchronized with game situational data, such as the time of the game, the score, location on the field, weather conditions, and the like which may affect the choice of play utilized. For example, in other exemplary embodiments, server may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein. The server can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user. A base module 7520 which initiates the wager module and then initiates the wager adjustment module and sends an updated bet database to the user device 7510. A wager module 7522 which uses the situational data from the historic bet database 7526 on previous wagers with the same situational data and performs correlations on the similar wagers in order to determine if there is a correlation from the historic data in order to extract and store the most re-occurring data point in order to update the odds in the bet database. A wager adjustment module 7524 which uses the most re-occurring data points that were extracted via the wager module and stored in the wager adjustment database and compares them to the threshold database in order to determine if the odds in the bet database should be updated based on the wager adjustments in the threshold database. A historic bet database 7526 which stores all the historic bets previously placed by users. A threshold database 7528 which is used to determine the appropriate adjustment in the wager odds by using the extracted most re-occurring data points and if one of the two data points exceeds the threshold database then the wager adjustment in the threshold database is used to update the odds in the bet database. A bet database which contains the current bets that users can place a wager on. A wager adjustment database which stores the most re-occurring data points extracted from the wager module along with the wager ID and wager in order to be compared with the threshold database in the wager adjustment module to determine if the odds in the bet database should be adjusted.

FIG. 76 displays the base module 7520. The process begins with the base module initiating the wager module, at step 7600. Then the base module initiates the wager adjustment module, at step 7602. Once the bet database has been updated, or not, via the wager module and wager adjustment module the base module sends the bet database to the user device 7510, at step 7604.

FIG. 77 displays the wager module 7522. The process begins with the wager module looking up the current wager in the bet database, at step 7700. Then the wager module finds the situational data for the wager ID, which may be the team, the quarter or time of the event, the down, the distance to gain, etc., at step 7702. The historic bet database is filtered on the situational data for the wager ID in order to find all the other previous wagers that have the same situational data, at step 7704. The first parameter in the historic bet database, for example the number of wagers placed, at step 7706. The wager module then performs correlations for all the other parameter data that has the same situational data and first parameter, at step 7708. It is then determined if there was a correlation above a predetermined threshold, for example, 90%, at step 7710. If there was a correlation above the predetermined threshold then the most re-occurring data point. For example, in FIG. 83B, the most re-occurring data point for the correlation of number of wagers against the total amount wagered would be 200 wagers and $7,500 wagered. These two data points along with the wager ID from the bet database would be stored in the wager adjustment database, at step 7712. Then the extracted data points are stored in the adjustment database, at step 7714. If it was determined there was no correlation above the predetermined threshold, then the wager module determines if there are any parameters remaining, at step 7716. If there are parameters remaining, the next parameter is selected and the process returns to step 7708, at step 7718. If it is determined there are no parameters remaining, it is then determined if there are any additional wagers in the bet database. If there are additional wagers, the process returns to step 7700, at step 7720. If there are no additional wagers the process returns to the base module, at step 7722. It should be noted that the betting module can be made available for access, reconfiguration, modification, or control for “customers” or used for “managed service user interface service”, “managed service risk management services”, “managed service compliance service”, “managed service pricing and trading service”, “managed service and technology platform”, “managed service and marketing support services”, “payment processing services”, “business applications”, “engaging promotions”, “customized betting”, “business applications”, “state based integration”, “game configurator”, “fantasy sports connector”, “software as a service”, “synchronization of screens”, “automatic content recognition (ACR)”, “joining social media”, “Augmented reality”, “digital gaming”, “Esports” or for user's to “cash out”.

FIG. 78 displays the wager adjustment module 7532. The process begins with the wager adjustment module being initiated by the base module, at step 7800. The wager adjustment module compares the wager adjustment database to the threshold database, at step 7802. It is determined if there is a match, for example the wager adjustment module has the most re-occurring data point which is 200 wagers and $7,500 wagered which when compared to the threshold results in the odds being decreased by 5%, at step 7804. If there is a match then the corresponding wager adjustment from the threshold database, for example a 5% decrease, is extracted, at step 7806. The wager ID from the wager adjustment database is also extracted in order to assist in adjusting the odds in the bet database, at step 7808. The extracted wager ID is matched with the corresponding wager ID in the bet database, at step 7810. The odds in the bet database are adjusted by the extracted wager adjustment, for example the 5% decrease from the threshold database. If the odds in the bet database are −105 and the wager adjustment is a 5% decrease then the odds in the bet database are adjusted and the new odds are −110, at step 7812. If there is no match from the wager adjustment database to the threshold database then the process returns to the base module, at step 7814.

FIG. 79 displays the historic bet database 7526 which contains all the wager data from previously placed wagers by users. The database may contain situational data such as the wager ID, the team the wager was for, the quarter or time period of the game or event, the down, the distance to gain, and what the wager was for. The historic bet database also contains parameter data for each of the wagers such as the number of wagers which is the number of individual wagers placed by users on the wager, the total amount wagered on the bet, the total amount paid out to the users from the wager, the total amount retained by the network, the profit and/or loss from the wager from the standpoint of the betting network, and the location of the wager which is where the individual user was located when the placed the wager. The database as currently shown is filtered for the situational data and the parameter of the location in order to determine if there is any correlations between the parameter data while filtered on the location parameter to see if odds should be adjusted for users within the Boston area when placing a wager on the New England Patriots. In some embodiments, the situational data may be user specific bet history or bets previous made by a specific user or group of users. In some embodiments, the situational data may be bet data collected from various sportsbooks by region, nation, or a combination of specific regions or nations. In some embodiments, the situational data may be a collection of wager odds from third parties, for example casinos, sportsbooks, sports apps or websites, etc. In some embodiments, the situational data may be collected from an odds marketplace which is a collection of various wager odds from third parties. In some embodiments, the situational data may be filtered on user preferences, for example certain sportsbooks the user uses or specific regions of the country or specific nations that may provide different wager odds.

FIG. 80 displays the threshold database 7528 which contains the various predetermined thresholds to be compared with the extracted data points from the wager module in order to determine if the odds in the bet database should be adjusted to account for user trends within placing the wagers. The database may contain the number of wagers, the amount wagered and the associated wager adjustment which is used to adjust the odds in the bet database.

FIG. 81 displays the bet database 7530 contains a list of all current wagers available to the users of the betting network. The database may contain the wager ID, the team, the quarter, the down, the distance to gain, the wager the odds, the current number of wagers and the current amount wagered. Other examples of wager data can be a “bet”, “wager”, “buy points”, “price”, “no action”, “sides”, “longshot”, “opening line”, “favorite”, “chalk”, “circled game”, “laying the points price”, “dog”, “underdog”, “money line”, “straight bet”, “straight-up”, “line”, “cover the spread”, “cover”, “tie”, “pick”, “pick-em”, “middle”, “parlay”, “round robin”, “teaser”, “prop bet”, “first-half-bet”, “half-time-bet”, “listed pitchers”, “run line”, “futures bet”, “future”, “handle”, “juice”, “vigorish”, “off the board” or “customized betting”.

FIG. 82 displays the wager adjustment database 7532 which stores the most re-occurring data points extracted from the wager module along with the wager ID and wager in order to be compared with the threshold database in the wager adjustment module to determine if the odds in the bet database should be adjusted. The database may contain the wager ID, the wager, and the extracted first parameter or first extracted data point shown on the x-axis in FIG. 83B, and the second extracted parameter or second extracted data point shown on the y-axis in FIG. 83B.

FIGS. 83A and 83B displays an example of the wager module 7522 and the resulting correlations. FIG. 83A: In this example the data that is filtered by the situational data and finding the various correlations with the number of wagers and the various parameters such as the profit and/or loss for a pass wager, for a run wager, etc. An example of non-correlated parameters with the situational data and the number of wagers and the profit and/or loss of the wager with a 15% (which is below the 90% threshold), therefore there is no correlation and no data should be extracted from the historic bet database and stored in the wager adjustment database. FIG. 83B displays an example of the correlations run in the wager module. In this example the data that is filtered by the situational data from the bet database and finding the various correlations with the number of wagers and the various patient parameters such as the total amount wagered for pass wager, the total amount wagered for run wager, etc. The highest correlated parameter with the number of wagers is the total amount wagered for a pass wager with a 95% (which is above the 90% threshold). Then the most re-occurring data point which is 200 wagers and $7,500 total amount wagered is extracted and stored in the wager adjustment database along with the wager ID from the bet database and this is compared to the threshold database which determines if any of these two data points are above a predetermined threshold to adjust the odds in the bet database.

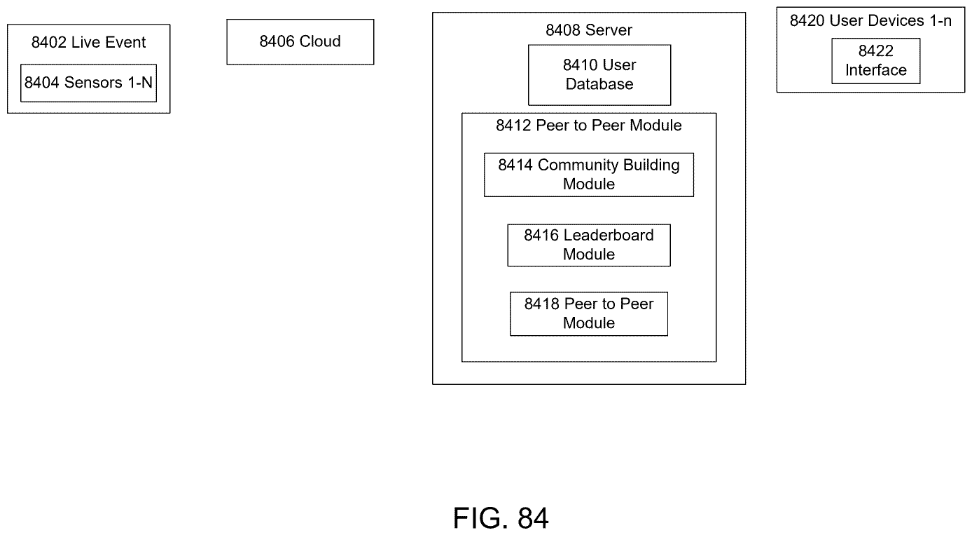

FIG. 84 illustrates a system for a community-based event driven wagering platform, according to an embodiment.

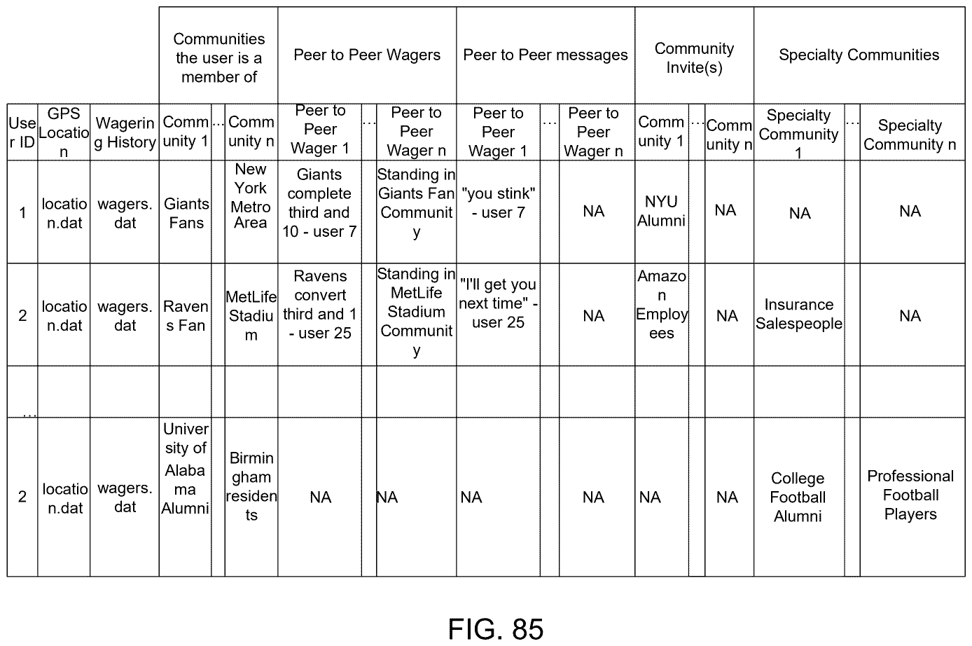

FIG. 85 illustrates a user database, according to an embodiment.

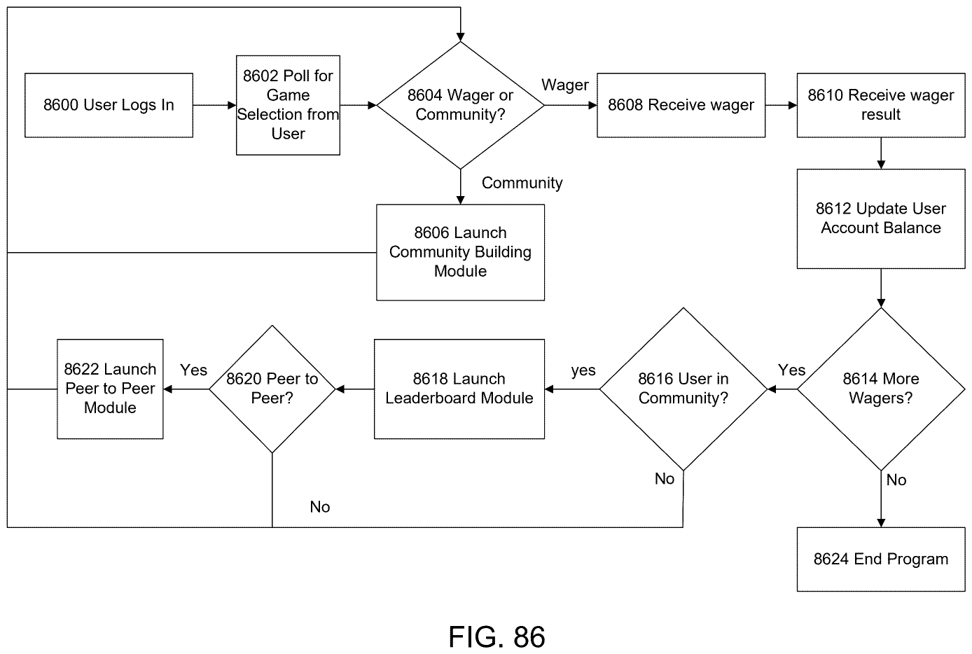

FIG. 86 illustrates a base wagering module, according to an embodiment.

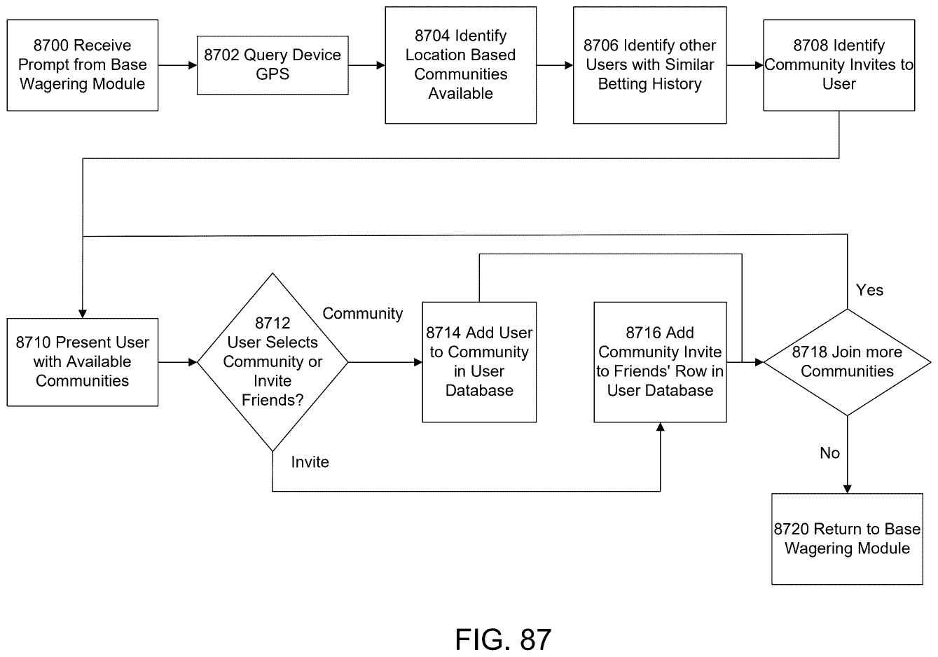

FIG. 87 illustrates a community building module, according to an embodiment.

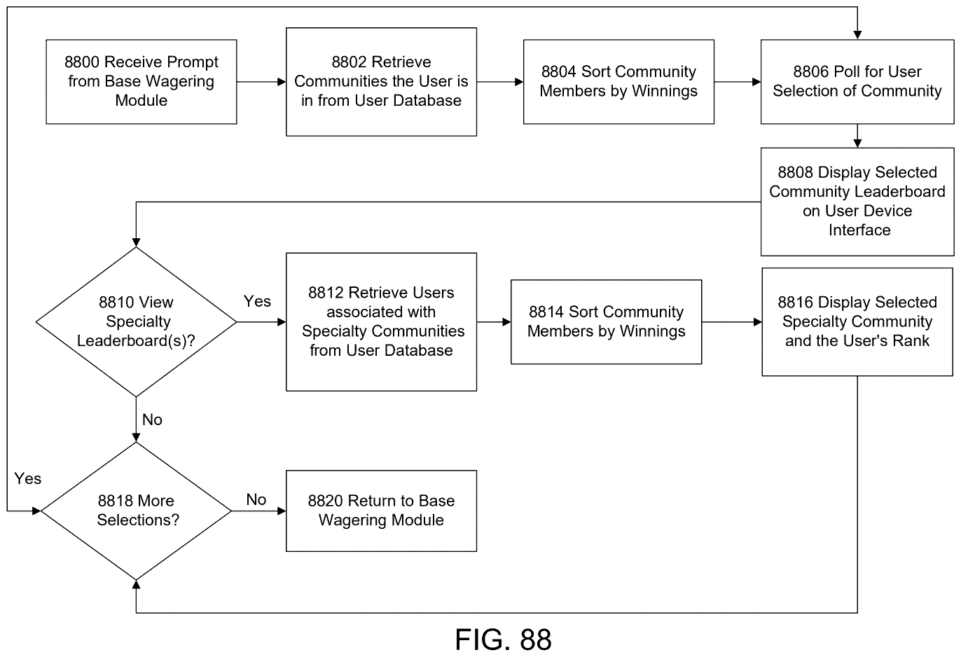

FIG. 88 illustrates a leaderboard module, according to an embodiment.

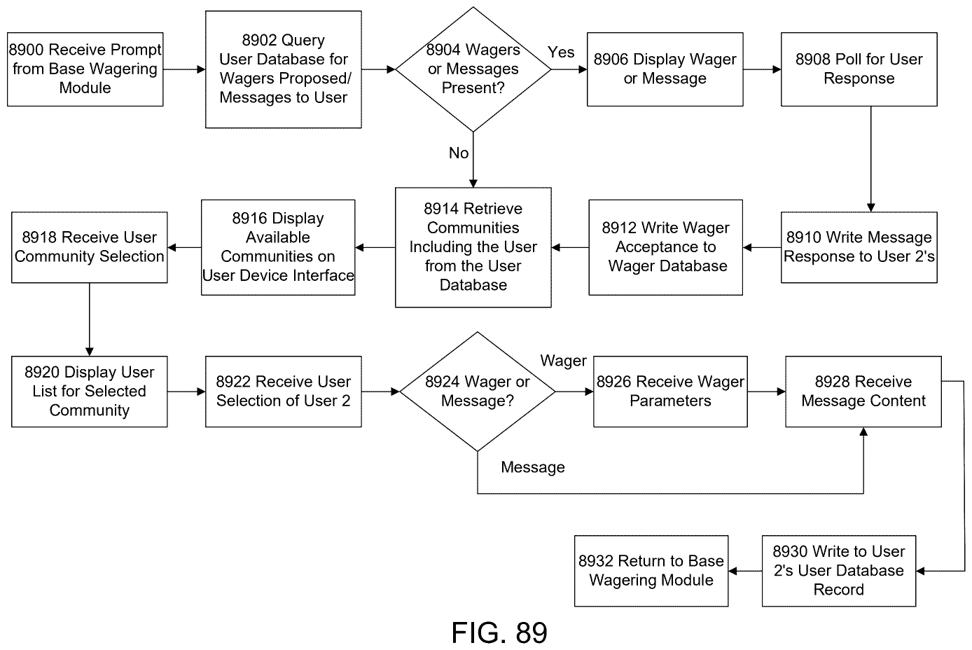

FIG. 89 illustrates a peer to peer module, according to an embodiment.

FIG. 84 displays a system for a community-based event driven wagering platform. This System includes a live event 8402, for example a sporting event such as a football game, basketball game, baseball game, hockey game, tennis match, golf tournament, eSports or digital game, etc. The live event 8402 will include some number of actions or plays, upon which a user or bettor or customer can place a bet or wager, typically through an entity called a sportsbook. There are numerous types of wagers the bettor can make, including, but not limited to, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 8402, such as the score of American football or the run line in baseball, or a series of action in the live event 8402. Sportsbooks have an amount of bets they can handle, a limit of wagers they can take on either side of a bet before they will move the line or odds off of the opening line. Additionally, there are circumstances, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event 8402 or at another location.

The system may include a plurality of sensors 8404 that may be used such as motion sensors, temperature sensors, humidity sensors, cameras such as an RGB-D camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors 8404 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball. The system also includes a cloud 8406 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance. The cloud 8406 may be communicatively coupled to server 8408 which may perform real time analysis on the type of play and the result of the play. The cloud 8406 may also be synchronized with game situational data, such as the time of the game, the score, location on the field, weather conditions, and the like which may affect the choice of play utilized. For example, in other exemplary embodiments, the cloud 8406 may not receive data gathered from sensors 8404 and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein.

The system may include a server 8408 which may perform real time analysis on the type of play and the result of a play or action. The server 8408 (or cloud 8406) may also be synchronized with game situational data, such as the time of the game, the score, location on the field, weather conditions, and the like which may affect the choice of play utilized. For example, in other exemplary embodiments, server 8408 may not receive data gathered from sensors 8404 and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein. The server 8408 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user. The user database 8410 contains all the relevant information for every user of the system That data includes, their user identification, their location data, their wagering history, any communities they are a member of, communities they've been invited to join, peer to peer wagers they have proposed or have had proposed to them by other users, peer to peer messages, such as taunting, and the users they came from or are to be delivered to, as well as any specialty communities the user is a member of, such as celebrities. The base wagering module 8412 allows the user to log in and place wagers on individual plays or events in a sporting event. In additional to processing wagers, the base wagering module 8412 calls when appropriate the community building module 8414, to allow the user to join communities of users, a leaderboard module 8416, to allow the user to see how they rank against other groups of users, and the peer to peer module 8418, to allow the user to send messages, such as taunts, to other users, as well as proposed wagers directly with other users. The community building module 8414 allows the user to join communities and invite others to join communities they are already a member of. The leaderboard module 8416 allows the user to see how they rank against other users in a community they are a member of, or a specialty community, such as professional athletes. The peer to peer module 8418 allows the user to message other users and propose wagers directly to other users. a user device such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. The user device 8420 can leverage the sensors in for purposes such as automatic content recognition, augmented reality or the synchronization of screens between the user device interface and other displays. The interface(s) 8422 may either accept inputs from users or provide outputs to the users, or may perform both the actions. In one case, a user can interact with the interface(s) 8422 using one or more user-interactive objects and devices. The user-interactive objects and devices may include user input buttons, switches, knobs, levers, keys, trackballs, touchpads, cameras, microphones, motion sensors, heat sensors, inertial sensors, touch sensors, or a combination of the above. Further, the interface(s) 8422 may either be implemented as a Command Line Interface (CLI), a Graphical User Interface (GUI), a voice interface, or a web-based user-interface.

FIG. 85 displays the user database 8410. The database contains all information about each user of the system. The first column contains their user identification. The second column contains their current location and location history. The third column contains their wagering history. The fourth column is for the communities the user is a member of, which each community 1-n having its own sub section. The fifth column records the peer to peer wagers the user has currently proposed or has had proposed to them, along the other user involved in the peer to peer wager, and the odds associated with the wager, each peer to peer wage having its own sub section. The sixth column contains peer to peer messages, such as taunting, along with the user who the message is from or being delivered to, each peer to peer message having its own sub section. The seventh column contains all communities that the user has been invited to join, either by the system for reasons such as the user's current location, or by a member of the community, each invitation having its own sub section. The final column contains an specialty community, such as celebrities, professional athletes and gamblers, or based on specific professions or other attributes of interest, each specialty community having its own sub section in FIG. 85.

FIG. 86 displays the base wagering module 8412. The process begins with the user logging into the play by play wagering system hosted on the server 8408. Play data can be any sensor data that indicates anything about the live game, such as, but no limited to audio of visual data that indicates “actions”, “sides”, “event” data, “total” data, “listed pitchers”, specific players, whistles, fouls, touchdowns, goals, yardage, player error, etc., at step 8600. The user is presented with games available to wager on through the user device interface and the module polls for the user's selection of the game they want to wager on, at step 8602. The base wagering module then receives the selection from the user of the game they wish to bet upon, or their desire to join a new community, at step 8604. If the user selects to join a community, the community building module 8414 is launched, at step 8606. If the user selects to make a wager, the wagers available for the selected game are presented to the user. This includes wagers that have been proposed to the user through the peer to peer module 8418. The user's selection of which wager they want to take, and the parameters, such as odds and wager amount, are received by the base wagering module. Wager data can be a “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “handle” or “juice” or “vigorish” or “off the board”, at step 8608. The base wagering module then receives the wager result, at step 8610. The wager result can come from a variety of sources including, but not limited to, a third-party statistics provider, sensor data on the field/players, image recognition systems, etc. The wager result could also be based on the user's position on a community leaderboard, in which that community has terms in which the top ranked player receives the largest payout, and the payouts decrease as the rankings descend and only a portion of the community members receive a payout. The base wagering module 8412 updates the user account balance, at step 8612. Determine if the user wishes to place more wagers, at step 8614. If the user wishes to make more wagers, determine if the user is at least one community, at step 8616. If the user is in at least one community, or has at least one community invited in their user database record, launch the leaderboard module 8416, at step 8618. When the leaderboard module 8416 is complete, poll the user for any desired peer to peer interactions, at step 8620. If the user elects to, launch the peer to peer module 8418, at step 8622. After the peer to peer module 8418 is complete the module goes back to step 304. When the user elects no more wagers at step 8614, the program ends. It should be noted that the base wagering module can be made available for access, reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”, at step 8624.

FIG. 87 displays the community building module 8414. The process begins with receiving a prompt from the base wagering module 8412, at step 8700. The community building module 8414 then queries the GPS of the user device to determine the user's physical location, at step 8702. The community building module 8414 allows for the identification all of the potential location based communities the user could join based on their current location, at step 8704. The community building module 8414 allows for the identification of other users with similar betting history. For instance, potential location based communities could be based on the broadcast area of a given team, so as to capture all the fans of that team. It could also be more localized to a particular town, or the stadium in which the game is being played, or any other type of area that makes sense for dividing viewers of a given game. The user database 8410 is then queried to identify users with a similar betting history to the user, at step 8706. The community building module 8414 allows for the identification of community invites. For example, similar betting history could be defined as, a plurality of wagers on a similar team, a similar winning percentage, a similar betting style, similar wager amounts, etc. The user database 8410 is then queried for any invites sent to the user from other community members at step 8708. The community building module 8414 present the user with all of the communities identified in steps 8704, 8706 and 8708, and display those communities for the user to select on the user device interface, at step 8710. The community building module 8414 allows the user to be presented with the option to invite another user to join a community of which they are a part. The system then receives the selection of available community or send a friend an invitation, at step 8712. The community building module 8414 allows the user to select a community to join, that community is added to the user's record in the user database 8410, at step 8714. The community building module 8414 allows the user to send a community invite to another user, the details of that invitation are written to the target user's record in the user database 8410, at step 8716. The community building module 8414 then polls the user for additional communities to join or friends to invite, at step 8718. The community building module 8414 allows for the user to join another community or invite another friend to a community the module returns to step 8710. If the user does not want to join another community or invite another friend, the module returns to the base wagering module 8412, at step 8720.

FIG. 88 displays the leaderboard module 8416. The process begins with the leaderboard module 8416 receives a prompt from the base wagering module 8412, at step 8800. The leaderboard module 8416 then retrieves, from the user database 8410, all communities the user is a member of, at step 8802. The leaderboard module 8416 allows for members of the identified communities are then sorted by their winnings, at step 8804. The leaderboard module 8416 then polls for the user's selection of which community they are a member of that they wish to view their standing on the leaderboard, at step 8806. The leaderboard module 8416 allows for each community is sorted individually. Winnings can mean total money or points won in a given time period, such as during the current game or series of games, or winning percentage, or some other method of ranking the users based upon their wagering history. The module then displays the selected community on the user device interface sorted by rank with the user's standing on the leaderboard highlighted, at step 8808.

The leaderboard module 8416 then determines if the user wants to view a specialty leaderboard, at step 8810. The leaderboard module 8416 allows for specialty leaderboards which are those that are not communities the user is a member of, but collections of people with a similar characteristic, such as celebrities, professional athletes, etc. If the user does not elect to view a specialty leaderboard, the module proceeds to step 8818. If the user selects one of the specialty leaderboards available, the modules retrieves from the user database 8410 all users associated with the selected leaderboard, at step 8812. The leaderboard module 8416 allows for the retrieved community of specialty users to be sorted by winnings, at step 8814. The leaderboard module 8416 allows for the selection of a specialty community leaderboard which is then displayed on the user device interface along with the user's relative rank amongst the community, at step 8816. The leaderboard module 8416 allows for the determination if the user has more communities to select, at step 8818. The leaderboard module 8416 allows for the user to select another community, the module returns to step 8806. If the user does not want to select another community leaderboard, the module returns to the base wagering module 8412, at step 8820.

FIG. 89 displays the peer to peer module 8412. The process begins with the peer to peer module 8418 allows for receiving a prompt from the base wagering module 8412, at step 8900. The peer to peer module 8418 then polls the user database 8410 for any wagers proposed, or messages sent to the user by another user that shares at least one community with, at step 8902. The peer to peer module 8418 then determines if there are any wagers or messages present, at step 8904. The peer to peer module 8418 then displays the wager proposed or message to user, at step 8906. The peer to peer module 8418 then polls for the user's response to the message or wager, at step 8908. The peer to peer module 8418 allows for the determination of the user response to a message, the user's response is written to user 2's (the user with whom the original user is communicating) record in the user database 8410, at step 8910. The peer to peer module 8418 allows for the determination of the users response to a proposed wager, the user's acceptance or rejection of the wager is recorded in user 2's record in the user database 8410, at step 8912. The peer to peer module 8418 then retrieves all of the communities the user belongs to from the user database 8410, at step 8914. The peer to peer module 8418 displays available communities on the user device interface and poll for a user selection, at step 8916. The peer to peer module 8418 receive the community selected by the user, at step 8918. The peer to peer module 8418 display the users in the selected community on the user device interface, at step 8920. The peer to peer module 8418 receives the user selection of which user, referred to as user 2, they wish to send a message to or propose a wager to, at step 8922. The peer to peer module 8418 polls for and receives the user selection of a wager to propose to user 2 or a message to send to user 2, at step 8924. The peer to peer module 8418 allows for the user to elect to propose a wager to user 2, the user enters the parameters, such as odds, amount and context, of the wager, at step 8926. The peer to peer module 8418 allows for the user to elect to send a message to user 2, such as taunting user 2 for a wager or game result, the message content is collected from the user, at step 8928. The peer to peer module 8418 allows for the content of the user message or the wager proposed is then recorded in the user database 8410 in user 2's record, at step 8930. The peer to peer module 8418 then returns to the base wagering module, at step 8932.

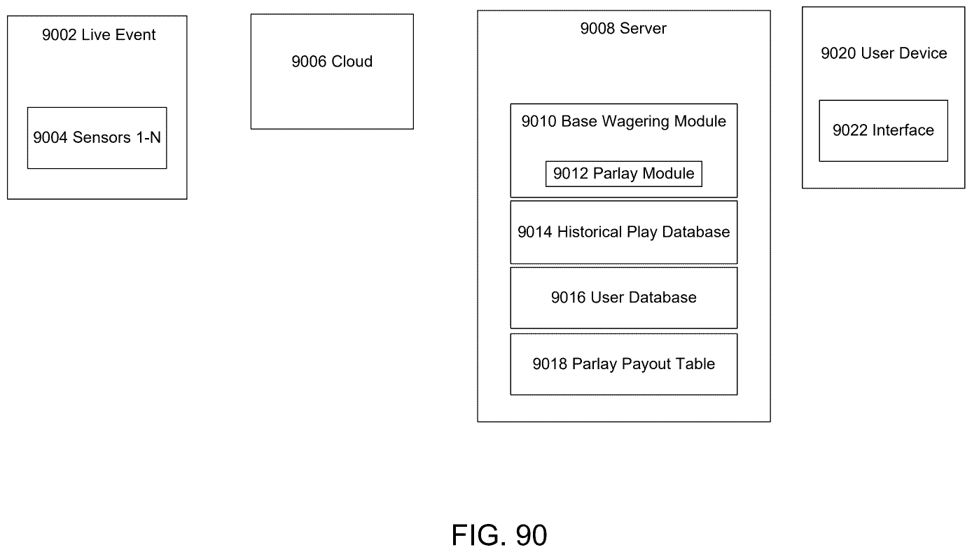

FIG. 90 illustrates a system for a play by play parlay, according to an embodiment.

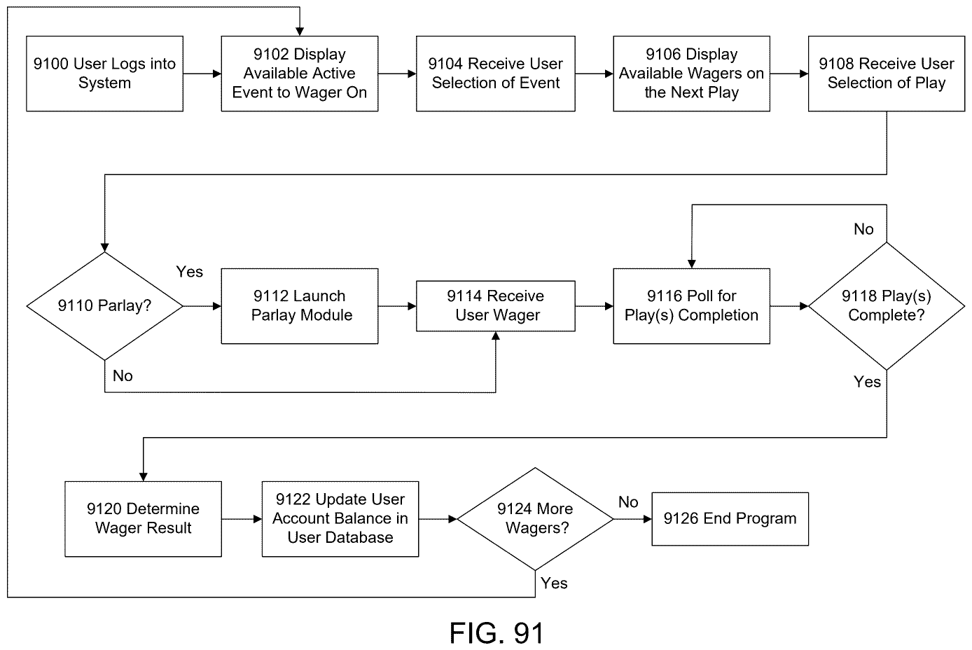

FIG. 91 illustrates a base wagering module, according to an embodiment.

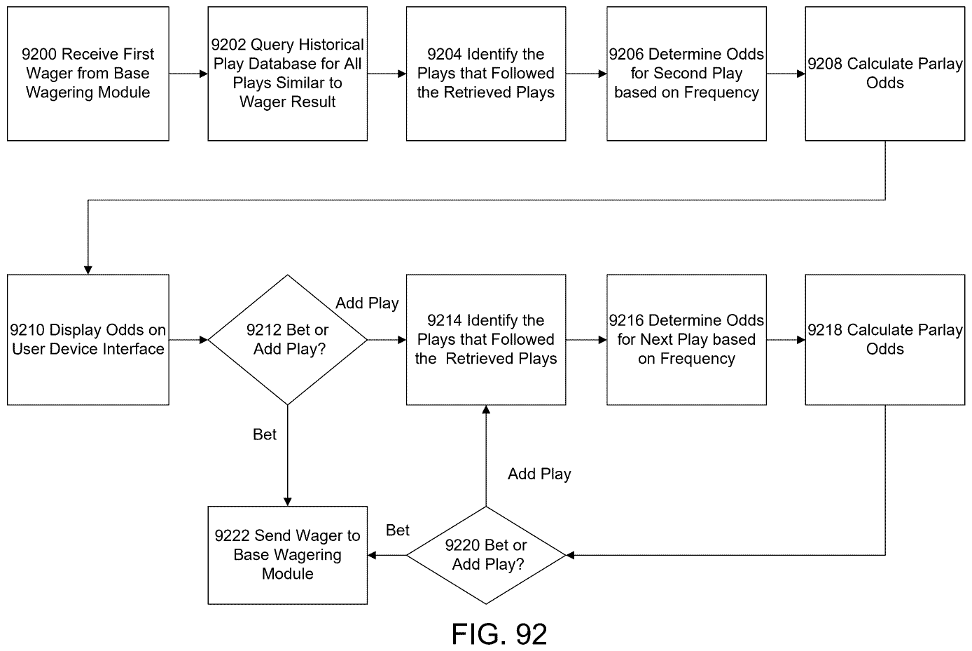

FIG. 92 illustrates a parlay module, according to an embodiment.

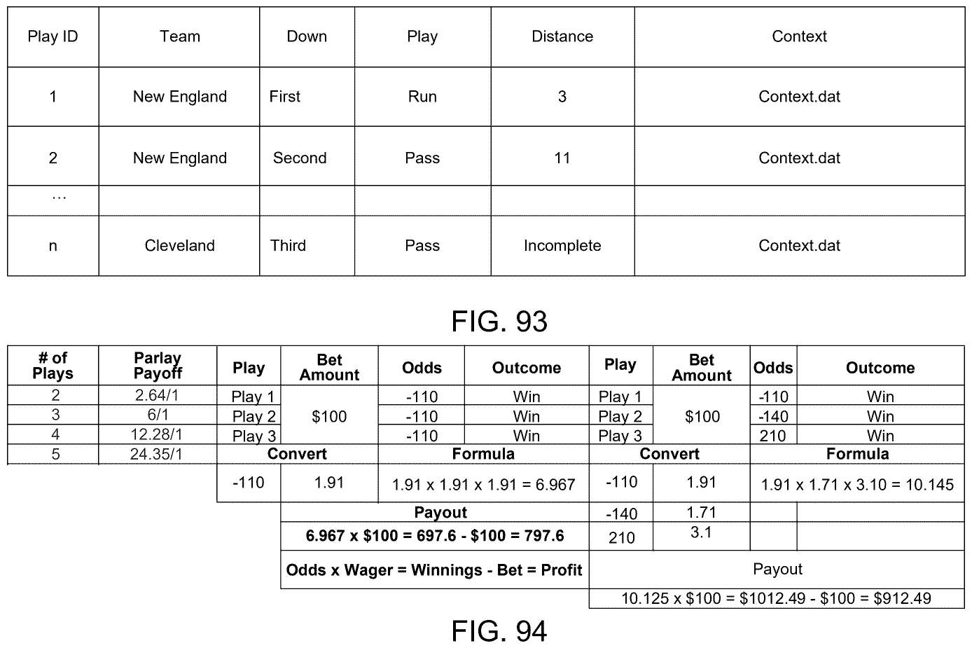

FIG. 93 illustrates a historical play database, according to an embodiment.

FIG. 94 illustrates a parlay payout table, according to an embodiment.

This is a system for a play by play parlay. FIG. 90 displays a system which includes a live event 9002, for example a sporting event such as a football game, basketball game, baseball game, hockey game, tennis match, golf tournament, eSports or digital game, etc. The live event 9002 will include some number of actions or plays, upon which a user or bettor or customer can place a bet or wager, typically through an entity called a sportsbook. There are numerous types of wagers the bettor can make, including, but not limited to, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event, such as the score of American football or the run line in baseball, or a series of action in the live event 9002. Sportsbooks have an amount of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event 9002 or at another location.

The system may include a plurality of sensors 9004 that may be used such as motion sensors, temperature sensors, humidity sensors, cameras such as an RGB-D Camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors 9004 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

The system also includes a cloud 9006 or communication network. The communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance. The cloud 9006 may be communicatively coupled to server 9008 which may perform real time analysis on the type of play and the result of the play. The cloud 9006 may also be synchronized with game situational data, such as the time of the game, the score, location on the field, weather conditions, and the like which may affect the choice of play utilized. For example, in other exemplary embodiments, the cloud 9006 may not receive data gathered from sensors and may, instead, receive data from an alternative data feed, such as Sports Radar. This data may be provided substantially immediately following the completion of any play and the data from this feed may be compared with a variety of team data and league data based on a variety of elements, including down, possession, score, time, team, and so forth, as described in various exemplary embodiments herein, at element 9006. The system may include a server 9008 which may perform real time analysis on the type of play and the result of a play or action. The server 9008 (or cloud 9006) may also be synchronized with game situational data, such as the time of the game, the score, location on the field, weather conditions, and the like which may affect the choice of play utilized. For example, in other exemplary embodiments, server 9008 may not receive data gathered from sensors and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein.

The server 9008 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user. The base wagering module 9010 allows the user to select the live event 9002 they wish to view available play or event based wagers, presents the user with the odds on those plays, collects individual wagers, monitors for play results and adjusts the users account balance according to the results. If the user wants to parlay multiple plays into one bet, the module 9010 prompts the parlay module 9012. The parlay module 9012 allows the user to combine at least two plays into a single wager. It calculates the payout the odds for the parlay based on what followed similar plays in the historical play database 9014. The historical play database 9014 contains all of the play data available to the system for odds making. The user database 9016 holds user account information as well as their current balance as it is updated by the base wagering module 9010 based upon wager results. The parlay payout table 9018 shows the method for calculating parlay odds and payouts. A user device 9020 may include a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. The user device 9020 can leverage the sensors in for purposes such as automatic content recognition, augmented reality or the synchronization of screens between the user device interface 9022 and other displays. The interface(s) 9022 may either accept inputs from users or provide outputs to the users, or may perform both the actions. In one case, a user can interact with the interface(s) 9022 using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) 9022 may either be implemented as a Command Line Interface (CLI), a Graphical User Interface (GUI), a voice interface, or a web-based user-interface.

FIG. 91 displays the base wagering module 9010. The base wagering module 9010 allows for the user to log in to the play by play wagering system hosted on the server 9008, at step 9100. The base wagering module 9010 then displays all live events that are available to place play by play wagers on. Wager selection information can be a “bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “handle” or “juice” or “vigorish” or “off the board”. Play data can be any sensor data that indicates anything about the live game, including, but not limited to, audio or visual data that indicates “actions”, “sides”, “event” data, “total” data, “listed pitchers”, specific players, whistles, fouls, touchdowns, goals, yardage, player error, etc., at step 9102. The base wagering module 9010 then receives the user's selection of which event, such as an American football game between the New England Patriots and the New York Jets, at step 9104. The base wagering module 9010 will then display the wagers available for the next play in the game, at step 9106. The base wagering module 9010 then receives the user's selection of which play they wish to wager on, at step 9108. The base wagering module 9010 then allows the user elect to wager, for example, that the next play will be a pass of more than 10 yards by New England. The module will then ask the user if they wish to turn their bet into a multi-play parlay, at step 9110. The base wagering module 9010 allows the user to wager on a parlay, and the parlay module 9012 is triggered, at step 9112. The base wagering module 9010 then proceeds with either the user's original single play wager, or the parlay wager returned from the parlay module 9012, at step 9114. The base wagering module 9010 then polls for the completion of the play, for an individual play wager, or plays for a parlay wager, at step 9116. If the play(s) are not complete, the base wagering module 9010 returns to step 9116. If the play(s) is (are) complete, the module proceeds forward, at step 9118. The base wagering module 9010, based on the result(s) of the completed play(s), calculate the wager result, at step 9120. The base wagering module 9010 allows for the account balance of the user to be updated based on the wager result, at step 9122. The base wagering module 9010 allows for the user to be polled for their desire to make more wagers, at step 9124. The base wagering module 9010 allows the user to elect to place another wager, and the module returns to step 9102. If the user elects to make no more wagers, the program ends. If the game is over, the program may end. It should be noted that the base module can be made available for access, reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting”, “Business Applications”, “State based integration”, “Game Configurator”, “Fantasy sports connector”, “Software as a service”, “Synchronization of screens”, “Automatic content recognition (ACR)”, “Joining social media”, and “Augmented reality”, at step 9126.

FIG. 92 displays the parlay module 9012. The parlay module 9012 allows for receiving a first play wager from the base wagering module 9010, at step 9200. The parlay module 9012 then queries the historical play database 9014 for all plays with a similar outcome the player has wagered on in them in their initial, at step 9202. The parlay module 9012 allows for the definition of a similar outcome which can vary widely depending on the sport and the size of the available dataset of similar plays in the historical play database 9014. For example, the user can bet that the New England Patriots would complete a pass of at least 10 yards on a third down and 8 play from their own 40 yard line, with 3 minutes to go in the first quarter of a September home game against the New York Jets, depending upon the size of dataset in the historical play database 9014. Additionally, context factors could include the personnel of the field, the formation of the offense and defense, along with aspects of the weather, such as temperature, humidity, precipitation, etc. Other relevant factors could include past wagers made by the user or any other user or group of users. With a large enough dataset, all of the previously listed aspects of the play could be used to filter the dataset for similar plays. The number of context factors used to filter for similar plays needs to be balanced with keeping the size of the set of similar plays remaining is large enough to be statistically significant in the odds making system used by the system. Once a statistically significant dataset of plays similar to the user's initial wager is identified, the module will retrieve from the historical play database 9014 all of the plays that followed the identified plays similar to the user's initial wager, at step 9204. The parlay module 9012 allows for many methods of calculating odds. The example used in this embodiment distributes the odds across the retrieved second plays by the frequency with which they occurred, at step 9206. The parlay module 9012 then calculates the odds of the current parlay which are demonstrated in the parlay payout table 9018, at step 9208. The parlay module 9012 allows for odds from the parlay payout module 9018 to be presented to the user via the user device interface 9022, at step 9210. The parlay module 9012 allows for the user to be given the option to place a bet on the display parlay or add another play to the parlay, at step 9212. The parlay module 9012 allows the user to elect to add an additional play to the parlay, the module queries the historical play database 9014 for all plays similar to the second play of the parlay in the same manner as is done in step 9202, at step 9214. The parlay module 9012 allows for calculating the odds for the plays, and to identify similar plays as in the same manner as in step 9204, at step 9216. The parlay module 9012 allows for the odds for the three play parlay are then calculated in the same manner as in step 9208, at step 9218. The parlay module 9012 allows for the user to be given the option to place a bet on the display parlay or add another play to the parlay, at step 9220. The parlay module 9012 will continually loop through steps 9214 to 9218 as the user adds plays to their parlay. Once the user has finished adding plays and elects to place a wager, the module sends that wager to the base payout module at step 9222.

FIG. 93 displays the historical play database 9014. The historical play database 9014 contains all the historical play data available to the system to determine odds. The first column is the play ID. The second column is the offensive team that ran that play. The third column is what down the play was run on; in other embodiments this could include the distance to a first down as well. The fourth column is the type of play run, such as a run, a pass, a kick, a punt, etc. The fifth column contains the results of the play, such as the yards gained or lost, an incomplete pass, points scored, etc. The sixth column is a data file containing all of the context factors the data can be sorted by to further filter the dataset being examined to determine odds. Examples of context include, the weather, the stadium the game is played in, the time in the game, the score of the game, the team's position on the field, etc. The larger the dataset, the more context factors can be used to filter the data. In an exemplary embodiment, the most context factors that still yield a statistically significant dataset would be used to calculate odds.

FIG. 94 displays the parlay payout table 9018. The table contains the parlay odds and payout calculations that are well known in the art. The first two columns contain the standard odds in most sportsbooks for combining multiple games in a parlay. While the system could use non-standard parlay rates as an individual play is a different proposition that a game, but for the purposed of the example embodiment, we will use the standard parlay payouts in the first two columns. The next four columns contain an example of a successful three play parlay. The user elected to wager $100 on three plays with the same −110 odds for their parlay. −110 odds converts to 1.91 in decimal odds. The three decimal odds value are multiplied together to get the total payout for the parlay, in this example 6.967. That number is multiplied by the original wager of $100, to yield a total payout of $696.70, minus the original wager of $100 yields a total profit to the user of $596.70. The final four columns show the same equation but with three plays that had differing odds.

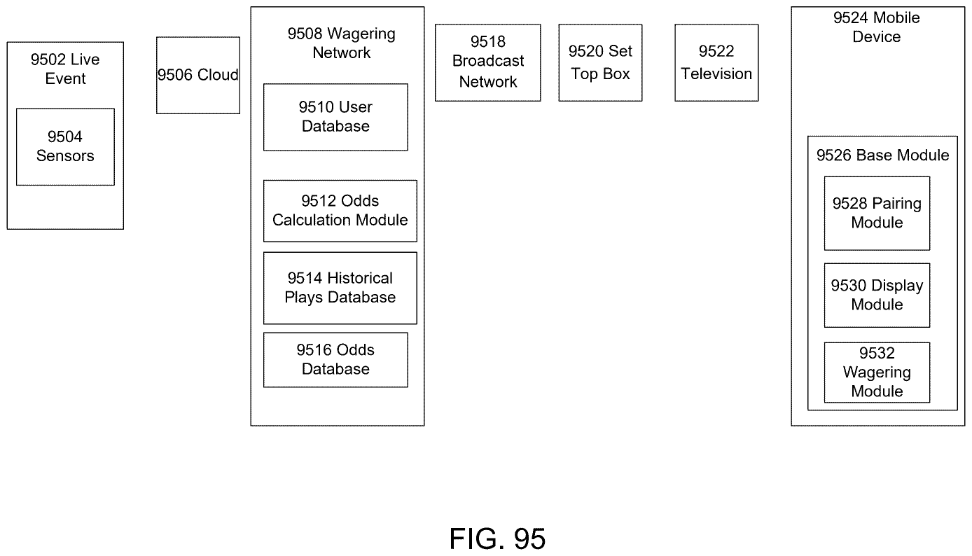

FIG. 95 illustrates a system for an interactive display for in-play wagering, according to an embodiment.

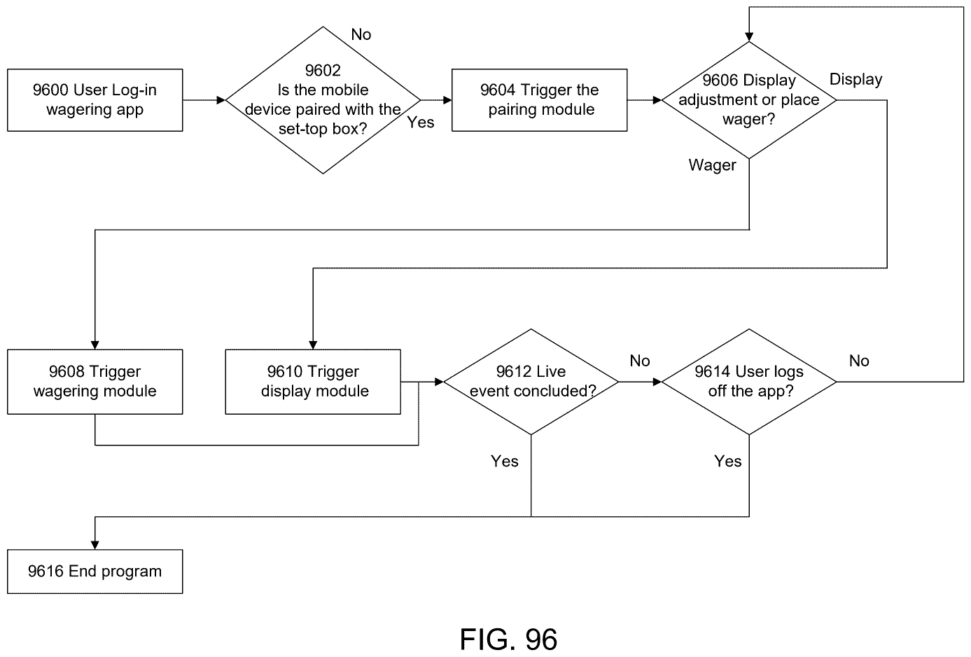

FIG. 96 illustrates a base module, according to an embodiment.

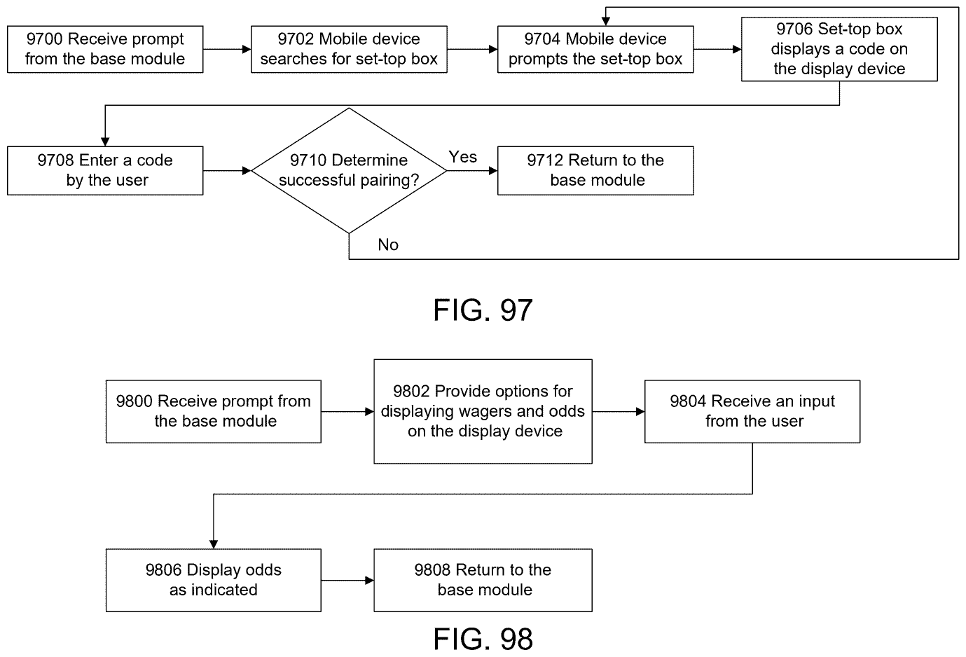

FIG. 97 illustrates a pairing module, according to an embodiment.

FIG. 98 illustrates a display module, according to an embodiment.

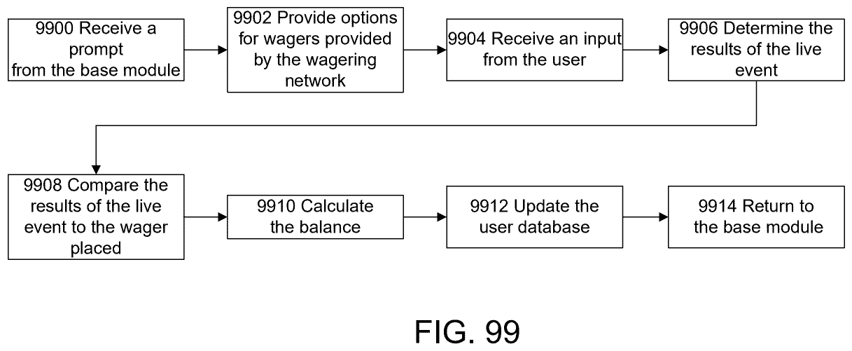

FIG. 99 illustrates a wagering module, according to an embodiment.

FIG. 95 displays a system for an interactive display for in-play wagering. This system comprises of a live event 9502, for example, a sporting event such as a football game, a basketball game, a hockey game, a tennis match, golf tournament, eSports or digital game, etc. The live event 9502 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round-robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 9502, such as the score of American football or the run line in baseball, or a series of action in the live event 9502. Sportsbooks have a number of bets they can handle, a limit of wagers they can take on either side of a bet before they will move the line or odds off of the opening line. Additionally, there are circumstance, such an injury to an important player such as a listed pitcher, in which a sportsbook, casino or racino will take an available wager off the board. As the line moves there becomes an opportunity for a bettor to bet on both sides at different point spreads to middle and win both bets. Sportsbooks will often offer bets on portions of games, such as first half bets and half-time bets. Additionally, the sportsbook can offer futures bets on live events 9502 in the future. Sportsbooks need to offer payment processing services to cash out customers. This can be done at kiosks at the live event 9502 or another location. For example, considering a live event 9502 being a baseball game that is played between the New York Yankees and the Los Angeles Dodgers, at Yankee Stadium, New York City.

Further, embodiments may include a plurality of sensors 9504 that may be used such as motion sensors, temperature sensors, humidity sensors, cameras such as an RGB-D camera which is a digital camera capturing color (RGB) and depth information for every pixel in an image, microphones, radiofrequency receiver, a thermal imager, a radar device, a LIDAR device, an ultrasound device, a speaker, wearable devices etc. Also, the plurality of sensors 104 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that collects statistical information through real-time X, Y positioning of players and X, Y, Z positioning of the ball. In the example of baseball game, the plurality of sensors 104 may be used for capturing parameters such as spin rate of the ball, speed of the ball, ball positions, launch angle, and exit velocity.

Further, embodiments may include a cloud 9506 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable resources and higher-level services that can be rapidly provisioned with minimal management effort, often over internet and relies on sharing of resources to achieve coherence and economics of scale, like a public utility, while third-party clouds enable organizations to focus on their core businesses instead of expending resources on computer infrastructure and maintenance. The cloud 9506 may be communicatively coupled to Wagering Network 9508 which may perform real time analysis on the type of play and the result of the play. The cloud 9506 may also be synchronized with game situational data, such as the time of the game, the score, location on the field, weather conditions, and the like which may affect the choice of play utilized. For example, in other embodiments, the cloud 9506 may not receive data gathered from sensors and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various embodiments herein.

Further, embodiments may include a wagering network 9508 which may perform real-time analysis on the type of play and the result of a play or action. The wagering network 9508 (or cloud 9506) may also be synchronized with game situational data, such as the time of the game, the score, location on the field, weather conditions, and the like which may affect the choice of play utilized. For example, in other embodiments, wagering network 9508 may not receive data gathered from sensors and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various embodiments herein. The wagering network 10008 can offer a number of software as a service managed services such as, user interface service, risk management service, compliance, pricing and trading service, IT support of the technology platform, business applications, game configuration, state-based integration, fantasy sports connection, integration to allow the joining of social media, as well as marketing support services that can create engaging promotions to the user.

Further, embodiments may utilize a user database 9510 which contains data relevant to all users of the wagering network 9508, which may include, a user ID, a device identifier, a paired device identifier, wagering history, and wallet information for the user. The user database 9510 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 9510 may contain betting lines and search queries. The user database 9510 may be searched based on a search criteria received from the user. Each betting line may include a plurality of betting attributes such as at least one of live event 9502, a team, a player, an amount of wager, etc. The user database 9510 may include information related to all the users involved in the live event 9502. In one example embodiment, the user database 9510 may include information for generating a user authenticity report and a wagering verification report. Further, the user database 9510 may be used to store user statistics like, but not limiting to, retention period for a particular user, frequency of wagers placed by a particular user, average amount of wager placed by each user, etc.

Further, embodiments may include an odds calculation module 9512 which utilizes information from historical plays database 9514 and the information from the sensor feeds 9504 to calculate odds for in-play wagers. The information from the historical plays database 9514 may include data related to the type of the play, the previous information related to players involved in the live event 9502, and results of the previous live events 9502. The odds for each live event 9502, such as in a baseball game, a particular player hitting a home run, a single, or a strikeout, may be calculated based on the information received from the sensor feeds 9504 and the previous information related to the particular player. Further, the odds may be updated based on in-game events (for example, a player strikes a home run with the same pitcher, decreasing his odds of getting a strikeout from the same pitcher). The odds may be calculated or adjusted based on statistical information related to the live event 9502 and the statistical information of the players. For example, the odds may be determined based on the historical data such as prior performance information about a player (like batting average against a certain pitcher, earned run average, catch probability, hamstring strain), and physiological information of player(s) etc., and current i.e. real-time information, such as current confidence level etc. In one embodiment, the type of wagering may depend on the type of game being played. In one embodiment, the odds calculation module 9512 may determine the available wagers to the user. The odds calculation module 9512 may also utilize a probability engine, which assembles all the historical data and real-time data and produces the odds (stored in the odds database 9516) for in-play wagers. Thus, the odds calculation module 9512 information relevant to all the potential outcomes, as available wagers, which facilitates the user with a better knowledge to make certain judgements about the potential performance of players in each live event 9502 and place a calculated wager with a potential return on the wager. For example, in baseball game, the odds calculation module 9512 may calculate odds related to the possible outcomes of an at-bat for Aaron Judge of New York Yankees hitting against the Clayton Kershaw of LA Dodgers, hitting a single are 4/1 (in moneyline+400), hitting a double are 5/1, hitting a home run are 3/1, and a strikeout are 2/1.

Further, embodiments may utilize a historical plays database 9514 that contains play data for the type of sport being played in the live event 9502. In one embodiment, for optimal odds calculation, the historical play data should include metadata about the historical plays, such as time of the live event 9502, location, weather, previous plays, opponent, physiological data of the players (including blood pressure, pulse rate, and respiration rate), batting average of all players, information related to the players such as injuries in the past, batting average, earned run average, catch probability, spin rate, launch angle, exit velocity, information related to trainers of each player, etc. For example, in the baseball game, information stored in the historical plays database 9514 may include information related to the previous baseball games played by the New York Yankees such as, but not limited to, the weather condition, i.e. during the match, it was cloudy.

Further, embodiments may utilize an odds database 9516 that contains the odds calculated by the odds calculation module 9512. The odds database 9516 stores all the odds and may be used by a mobile device base module 9526 to display the odds on the display device 9522, and to take bets from the user through the mobile device wagering module 9532. In one embodiment, the type of wagering may depend on the type of game being played.

Further, embodiments may include a broadcast network 9518 that is the rights holder delivering the live event 9502 to the set-top box 9520 based upon the user's media subscription. The broadcast network 9518 may broadcast or simulcast in real-time throughout the real world using existing and conventional video transport media, such as web, TV, satellite, telephone network, and cable. The live event 9502 may be broadcasted in real-time, via the broadcast network 9518, with live computer-generated commentary (e.g., in a plurality of languages) that involves moment-by-moment commentary of the action. The broadcast network 9518 may collect information from the sensor feed 9504 (for example, the video feed and the audio feed, related to the live event 9502). The live event 9502 may be simulcast, allowing the users to watch and wager on the live event 9502. The broadcast network 9518 may also display data about the live event 9502 and produce hardcopy materials for posters and magazines. The broadcast network 9518 may also televise the live event 9502 with self-contained video rendering, playback, and caption generator, for the case of access of the user. The broadcast network 9518 may also include an integrated event which allows the user to switch to an alternate video stream.

Further, embodiments may include a set-top box 9520 which receives media content from the broadcast network 118, that is displayed on the display device 9522. The set-top box 9520 may be connected to the display device 9522 via the HDMI connection. Other connections may include a power cable coupling the set-top box 9520 to an external cable source, and a category five (Cat 5) cable coupling the set-top box 9520 to an external pay-per-view source. The set-top box 9520 may include a dongle capable particular technology and functionality extensions thereto. The set-top box 9520 may act as an intermediate between a mobile device 9524 and the display device 9522. Further, the positioning of the set-top box 9520 may vary depending on environment and application and, with certain functionality, the set-top box 9520 may be placed more discreetly behind the display device 9522. Moreover, it should be appreciated that the set-top box 9520 and the display device 9522 may be at least partially or fully integrated, in element 9520.

Further, embodiments may include a display device 9522. The display device 9522 may be any electronic visual display device, for example, and connected to the set-top box 9520 via a high-definition multimedia interface (HDMI) connection. The display device 9522 may include an array of buttons for adjusting various settings such as display device channel and volume and allowing for various inputs during the installation, maintenance, or repair of the set-top box 9520 and the display device 9522. Further, the display device 9522 may be configured to generate a code (for example, a machine-readable optical label or a Quick Response, QR, code) to couple the mobile device 9524 to the display device 9522. In one embodiment, the display device 9522 may offer connectivity through a consumer infrared (IR), Bluetooth or other wireless-protocol-based means to control the display device 9522 via the set-top box 9520 or the mobile device 9524, for example. The display device 9522 may display the live event 9502 to include in-play wagering odds available to the user from the wagering network 9508. The display device 9522 may display the information related to the current wager from the historical plays database 9514. For example, the display device 9522 may display in-play wagering odds related to a particular player and information related to previous matches of the particular player. Further, the display device 9522 may display odds related to the live event 9502 i.e. a game, in the form of a ribbon may be displayed below/on one side of the game on a screen of the display device 9522, depending on the type of sport. The display device 9522 may display the ribbon of potential wagers on the display device screen and control the wager selections through the mobile device 9524. In one embodiment, the content displayed on the display device 9522 may be customized by the user (for example, size of the in-play waging odds on the display device screen). In one embodiment, the odds related to the live event 9502 may be overlaid on a particular player or on the field. In one embodiment, in the baseball game, the odds related to the live event 9502, may be displayed as a graphic on the field, odds of a hitter may be overlaid on the hitter, odds of a pitcher may be displayed on an edge of the screen of the display device 9522. In an embodiment, the display device 9522 may be a television or projection screen, for example.

Further, embodiments may include a mobile device 9524 that can pair with the set-top box 9520 to allow the user to both adjust the display of the live event 9502 on the display device 9522 to include in-play wagering odds available to the user from the wagering network 9508 in various visual representations, as well as allow the user to place the wagers related to live event 9502. The mobile device 9524 may include input modules like a keypad, touchscreen, microphones, cameras, proximity sensors and other sensors for receiving input from the user. The mobile device 9524 may also include output modules like speakers, display screen, and infrared transmitter, for communication with the user and with the display device 9522. The mobile device 9524 may be connected to the display device 9522 via infrared (IR), Bluetooth or other wireless-protocol-based means. In one embodiment, while watching the live event 9502, the user of the mobile device 9524 may use an application and scan a code or enter a code unique to the display device 9522. Further, the mobile phone 9524 will then control the connection between the user and the display device 9522. The mobile device 9524 may scan a code displayed on the display device 9522 for pairing with the display device 9522. The mobile device 9524 may also support augmented reality (AR) technology, enabling the user to interact with the display device 9522, via AR. The mobile device 9524 may also be able to detect air gestures as indicated by the user, for controlling actions on the display device 9522 like a particular gesture for placing a wager etc. For example, in the baseball game, the user may select the option of displaying the odds or wagers, in the form of a ribbon, on the bottom area of the screen of the display device 9522.

Further, embodiments may include a base module 9526 that allows the user to pair their mobile device 9524 with the set-top box 9520 and the wagering network 9508 to allow the user to both place wagers and manipulate the display of the live sporting event to integrate available in-play wagers on the display device 9522. Further, the base module 9526 may allow the user to log-in/sign-in the wagering app, i.e. wagering app, during the live event 9502. Further, the base module 9526 may determine whether the mobile device 9524 is paired with the set-top box 9520. In one case, if the mobile device 9524 is not paired with the set-top box 9520, then the base module 9526 may trigger the pairing module 9528, to pair the mobile device 9524 with the set-top box 9520. Further, upon successful pairing, the base module 9526 may trigger a display module 9530, to allow the users with options to manipulate how the available wagers and odds on different in-play events are displayed or to place a wager related to the live event 9502. Further, when the user selects to place a wager, then the base module 9526 may trigger a wagering module 9532, which enables the user to select from available wagers from the wagering network 9508. Further, when the user selects to adjust the display, then the base module 9526 may trigger the display module 9530 to manipulate how the available wagers and odds on different in-play events are displayed. Further, the base module 9526 may constantly monitor the live event 9502 to conclude on the wagers placed by the user or to continue facilitating the user with options to adjust the display of the display device 9522 or to place a wager related to the live event 9502. Thereafter, the base module 9526 may constantly monitor if the user logs-off from the app, during the live event 9502.

Further, embodiments may include a pairing module 9528 which allows the user to connect their mobile device 9524 with the set-top box 9520 to allow the user to control the output of the set-top box 9520 to the display device 9522 with their mobile device 9524. In a scenario, after signing in, the base module 9526 may trigger the pairing module 9528 to offer a user to pair with the set-top box 9520. First, the mobile device 9524 may search for identifying the set-top box 9520, based on one or more parameters such as, but are not limited to, proximity to the mobile device 9524. Second, the mobile device 9524 may prompt the identified set-top box 9520 for pairing with the mobile device 9524. Third, the set-top box 9520 may initiate the pairing process by displaying a code on the display device 9522. In one embodiment, the display device 9522 may display a QR code or another code, for pairing with the mobile device 9524. After the code is displayed on the display device 9522, the user may enter the code manually or scan a QR code (displayed on the display device 9522) via the mobile device 9524. Thus, upon entering the correct code, the pairing module 9528 may be configured to pair the mobile device 9524 with the set-top box 9520. In one embodiment, during the pairing process, the display device 9522 displays a code “7777”, then the user is required to enter the code “7777” on the mobile device 9524, for successful pairing of the mobile device 9524 with the set-top box 9520. In one embodiment, the display device 9522 may display a QR code and the user may scan the QR code with their mobile device 9524, which may complete the pairing process. Successively, the pairing module 9528, upon successful pairing of the mobile device 9524, allows the user to control the output of the set-top box 9520. In another case, if the pairing is unsuccessful, then the pairing module 9528 may send the information regarding the unsuccessful pairing, to the base module 9526.

Further, embodiments may include a display module 9530 which allows the user to manipulate how the available wagers and odds on different in-play events are displayed. Once the mobile device 9524 is paired to the set-top box 9520, the base module 9526 may trigger the display module 9530 to offer multiple options for displaying the odds. The display module 9530 may offer the user to select from multiple options for displaying the odds available in the in-play live event 9502. The options available for displaying the odds may be, but are not limited to, displaying the odds in a ribbon formation, for example on the bottom section of the display device 9522, on the top section of the display device 9522, on either sides of the display device 9522, or as an overlay on a particular player. Further, the display module 9530 may facilitate the user to manipulate the contents displayed on the display device 9522 (for example, size of the in-play waging odds on the display device screen). In one embodiment, the odds related to the live event 9502 may be overlaid on a particular player. For example, in the baseball game, the display module 9530 may enable the user to control the viewing of odds related to the live event 9502, i.e. the odds may be displayed as a graphic on the field, odds of the hitter hitting a single, may be overlaid on the hitter; odds of the pitcher getting a strikeout, may be displayed on an edge of the screen of the display device 9522. Further, the display module 9530 may receive an input from the user related to how the wagers or odds be displayed on the display device 9522. In one embodiment, the user may select the option of displaying the wagers or odds, in the form of a ribbon, on the bottom area of the screen of the display device 9522 like displaying the odds. Based on the user's input, the display device 9522 may reflect a corresponding change in the way how the wagers or odds are being displayed on the display device 9522. In one embodiment, the display device 9522 displays the wagers or odds in the form of a ribbon, on the bottom area of the screen of the display device 9522. After reflecting the change on the display device 9522, it returns back to the base module 9526. Based on the options offered to the user, the user may select a particular option. The wagering module 9532 may collect the wager and transmit the wager to the wagering network 9508. For example, if the user has an opening balance of $2000 and places a wager of $100 on Aaron Judge of New York Yankees, hitting a single against the Clayton Kershaw of LA dodgers at +400 odds. Further, when play in the live event 9502 is concluded, then the results of the live event 102 are received. In one embodiment, the result of the live event 9502 is Aaron Judge of New York Yankees, playing in the 3rd inning against the Clayton Kershaw of LA dodgers, hits a single. The result of the play may be used to update the information in the historical plays database 9514. In one embodiment, the result of the wager may be displayed via the display device 9522, to the user.

Further, embodiments may include a wagering module 9532 that may compare the result of the play with the wagers placed by the user, to determine a result of the wager i.e. whether the user has won or loss. Based on the comparison of the result of the live event 9502 and the wagers placed by the user, the result of the wager may be used to calculate the balance for the user. Based on the comparison of the result of the play, with the wagers placed by the user, the wagering module 9532 may deliver the information related to the result of the wager to the user database 9510. Further, the information related to the result of the wager may be used to update the balance amount of the user, based on the wager earned/lost. For example, if Aaron Judge hits a single, then the user would make a profit of $400, as per the initial wager ($100) placed at +400 odds. Thus, the updated balance of the user (with an opening balance of $2000), after the completion of the live event 102, will be $2000+$400=$2400. Further, the updated balance of $2400 of the user may be prompted to update the information related to the user, in the user database 9510. Further, the wagering module 9532 monitors the live event 9502, until a predefined condition is met. In one embodiment, the predefined condition may be that the user has logged out of the live event 9520 or the live event 9502 has ended. In addition, at the end of the live event 9502, the user may be prompted with a message reminder for a next live event, as a recommendation.

FIG. 96 illustrates the base module 9526. The process begins as the base module 9526 is triggered when the user logs—in, at step 9600, to the wagering network 9508 through an app on the mobile device 9524, i.e. a wagering app. The base module 9526 may facilitate the user to pair their mobile device 9524 with the set-top box 9520 and the wagering network 9508, thus allowing the user to both place wagers and manipulate the display of the live event 9502 to integrate available in-play wagers on the display device 9522. After logging in to the wagering app, the base module 9526 determines, at step 9602 whether the mobile device 9524 is paired with the set-top box 9520. In one case, if the mobile device 9524 is paired with the set-top box 9520, then the base module 9526 may facilitate the user with options to adjust the display of the display device 9522 or to place a wager related to the live event 9502. In another case, if the mobile device 9524 is not paired with the set-top box 9520, then the base module 9526 may trigger the pairing module 9528, at step 9602. The pairing module 9528 may be triggered, at step 9604, to allow the user to pair the mobile device 9524 with the set-top box 9520 to allow the user to control the output of the set-top box 9520 with their mobile device 9524. In one embodiment, the pairing process may be done by entering a code unique to the display device 9522, on the mobile device 9524. Upon pairing of the mobile device 9524 with the set-top box 9520, the base module 9526 may facilitate the user with options to adjust the display of the display device 9522 or to place a wager related to the live event 9502, at step 9606. In one case, if the user selects to place the wager, then the base module 9526 may trigger, at step 9608 the wagering module 9532. The wagering module 9532 may allow the user to select from available wagers offered by the wagering network 9508. In another case, if the user selects the display adjustment, then the base module 9526 may trigger, at step 9610 the display module 9530 to manipulate how the available wagers and odds on different in-play events are displayed. The base module 9526 may constantly monitor, at step 9612, the live event 9502, for completion. In one case, when the live event 9502 is concluded, the base module 9526 may again trigger the wagering module 9532, to conclude on the wagers placed by the user. In another case, when the live event 9502 is not concluded, then the base module 9526 may continue facilitating the user with options to adjust the display of the display device 9522 or to place a wager related to the live event 9502. The base module 9526 may also constantly monitor, at step 9614 if the user logs-off from the app, during the live event 9502. In one case, when the user logs-off from the app, then the base module 9526 may again trigger the wagering module 9532, to conclude on the wagers placed by the user. In another case, when the user does not logs-off from the app, then the base module 9526 may continue facilitating the user with options to adjust the display of the display device 9522 or to place a wager related to the live event 9502. Thereafter, the program ends, at step 9616.

FIG. 97 displays the pairing module 9528. The process begins with the pairing module 9528 may receive a prompt, at step 9700 from the base module 9526, for pairing the mobile device 9524 with the set-top box 9520. The mobile device 9524 may search, at step 9702, for a set-top box 9520, based on one or more parameters such as, but are not limited to, proximity to the mobile device 9524. The mobile device 9524 may prompt the identified set-top box 9520 for pairing with the mobile device 9524, and thus initiating a pairing process between the mobile device 9524 and the set-top box 9520. The set-top box 9520 may initiate the pairing process by displaying, at step 9706 a code on the display device 9522. In one embodiment, the display device 9522 may display a QR code or an alphanumeric code, for pairing with the mobile device 9524. After the code is displayed on the display device 9522, the user may, at step 9708 enter the code manually or scan a QR code (displayed on the display device 9522) via the mobile device 9524. Thus, upon entering the correct code, the pairing module 9528 may be configured to pair the mobile device 9524 with the set-top box 9520. In one embodiment, during the pairing process, the display device 9522 displays a code “7777”, then the user is required to enter the code “7777” on the mobile device 9524, for successful pairing of the mobile device 9524 with the set-top box 9520. The pairing module 9528 may then determine, at step 9710, whether the pairing is successful. In one case, if the pairing is successful, then the pairing module 9528 may allow the user to control the output of the set-top box 9520. In another case, if the pairing is unsuccessful the process can return to step 9704 to attempt the pairing process again. If the user does not want to attempt the pairing again, then the process returns to the base module 9526. Once pairing process is complete the process returns, at step 9712, to the base module 9526.

FIG. 98 illustrates the display module 9530. The process begins with the display module 9530 receiving, at step 9800, a prompt from the base module 9526. It can be noted that the display module 9530 is triggered when the user wants to manipulate how the available wagers and odds on different in-play events will be displayed. After receiving the prompt from the base module 9526, the display module 9530 may display, at step 9802, a list of options on how the wagers or odds may be displayed on the display device 9522. In one embodiment, the odds related to the live event 9502, may be overlaid on a particular player or on the field. Further, the display module 9530 may display options for displaying odds related to the live event 9502, i.e. a game, in the form of a ribbon displayed either on the bottom area/on one side of the game, or on a screen of the display device 9522, depending on the type of the sport. In one exemplary embodiment, in the baseball game, the display module 9530 may enable the user to control the viewing of odds related to the live event 9502, i.e. the odds may be displayed as a graphic on the field, odds for a variety of outcomes for the hitter (i.e. +400 single), may be overlaid on the hitter; odds for a variety of outcomes for the pitcher (i.e. +300 for a strikeout) may be displayed on an edge of the screen of the display device 9522. In another embodiment, the available wagers could be overlaid on parts of the field or game play area correlated to available wagers, such as home run odds being overlaid on the outfield fence or the stands beyond it. The display module 9530 may receive, at step 9804, an input from the user related to how the wagers or odds be displayed on the display device 9522. In one embodiment, the user may select the option of displaying the wagers or odds, in the form of a ribbon, on the bottom area of the screen of the display device 9522. Based on the user's input, the display of the live event 9502 is integrated with the available wagers on the display device 9522 to be displayed, at step 9806, as the user indicated in step 9804. In one embodiment, the display device 9522 displays the wagers or odds in the form of a ribbon, on the bottom area of the screen of the display device 9522. After reflecting the change on the display device 9522, it returns, at step 9808 to the base module 9526.

FIG. 99 illustrates the wagering module 9532. The process begins with the wagering module 9532 may receive a prompt, at step 9900, from the base module 9526. It can be noted that the wagering module 9532 may be triggered when the user wants to place a wager in the live event 9502. After receiving the prompt from the base module 9526, the wagering module 9532 may offer, at step 9902 multiple wagers available to the user to place a wager related to the live event 9502. For example, the wagering module 9532 may offer options including a wager of +400 on Aaron Judge of New York Yankees hitting a single in his at bat in the third inning against the Clayton Kershaw of LA dodger, or a wager of +650 him hitting a homerun. The wagering module 9532 may receive, at step 9904 a wager selection from the user. For example, placing a wager of $100 at +400 odds on Aaron Judge hitting a single off of Clayton Kershaw. The wagering module 9532 will then determine, at step 9906, the result of the wagered upon play in the live event 9502. This may be in the form of a prompt from the wagering network 9508 that the play is concluded along with the results, or from the live event 9502 broadcasters, a 3rd party statistics service, or as is in this example, the sensors 9504 are monitored for the completion of and results of the play. Further, the wagering module 9532 may compare, at step 9908, the result of the live event 9502 with the wagers placed by the user, to determine a result, i.e. whether the user has won or loss. In this example, the wager of $100 placed for Aaron Judge hitting a single of Clayton Kershaw and the result of the live event 9502, i.e. Aaron Judge hitting a single, are compared to determine the result of the wager. Based on the comparison of the result of the live event 9502 and the wager placed by the user, the balance amount may be calculated, at step 9910, for the user. For example, the user wins the wager of $100 at +400 odds that Aaron Judge will hit a single on the next play and the result of the live event 9502 is Aaron Judge hitting a single. Thus, the updated balance of the user (with an opening balance of $2000), after the completion of the live event 9502, will be $2000+$400=$2400. The wagering module 9532 will update, at step 9912 the account balance of the user who place the wager in the user database 9510. In this example, after winning the wager of $100 placed at +400 odds, the updated balance of the user is $2400. Once the user database 9510 is updated with the result of the wager, the process returns, at step 9914 to the base module 126.

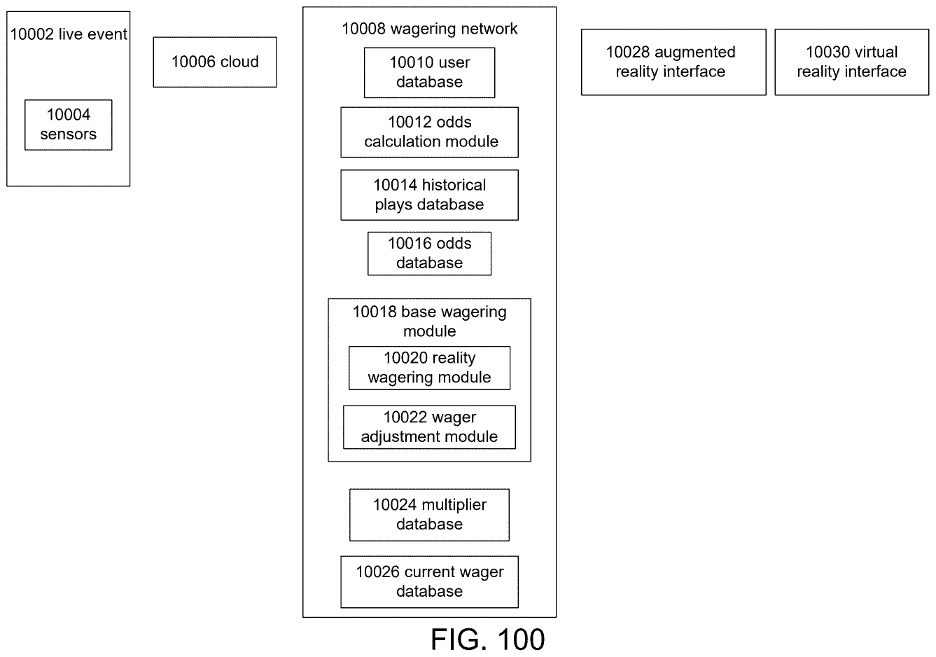

FIG. 100 illustrates a system for an AR VR In-Play Wagering System, according to an embodiment.

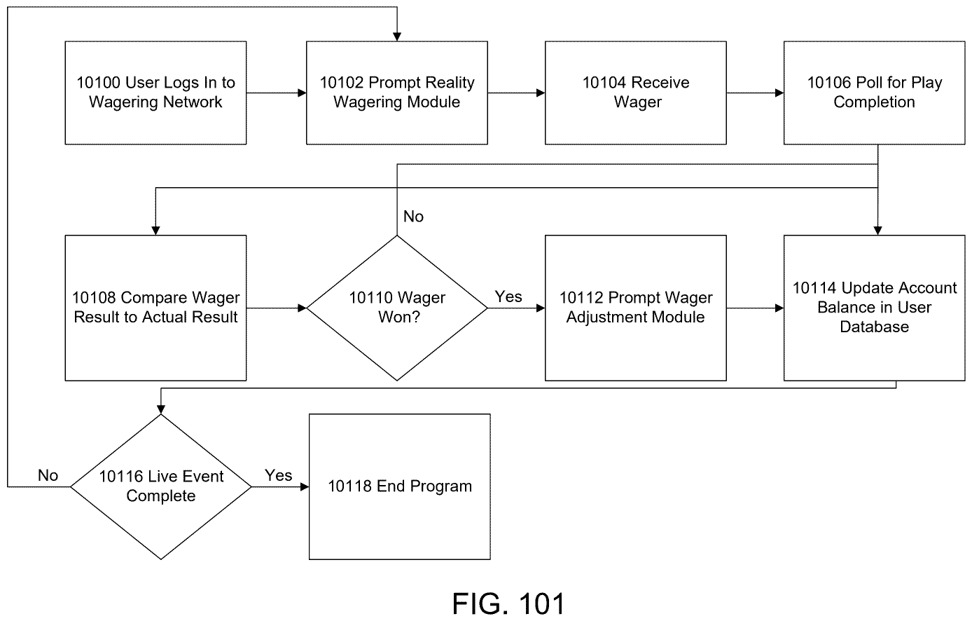

FIG. 101 illustrates a base wagering module, according to an embodiment.

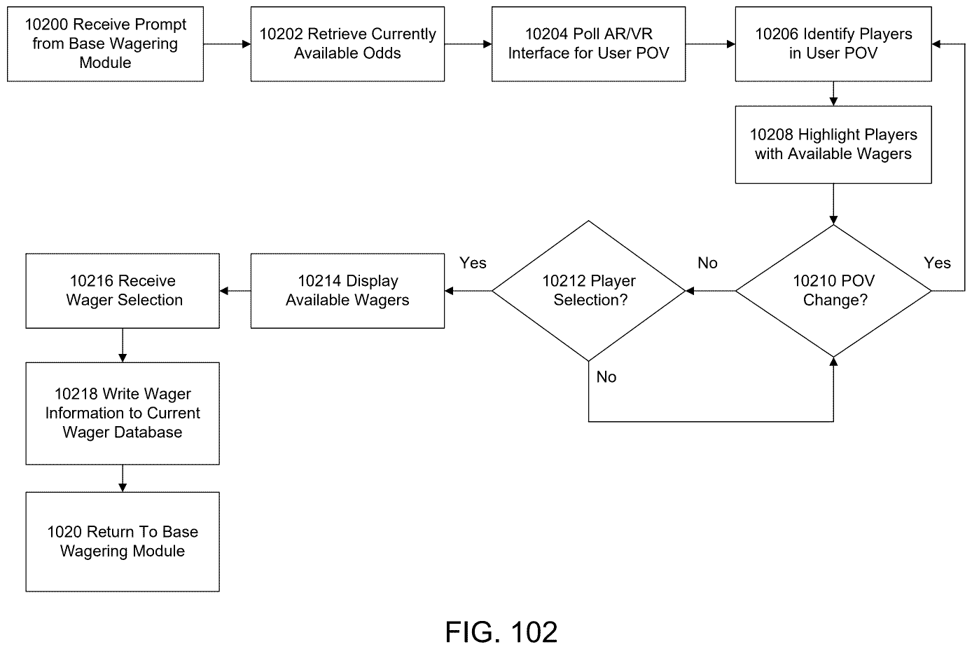

FIG. 102 illustrates a reality wagering module, according to an embodiment.

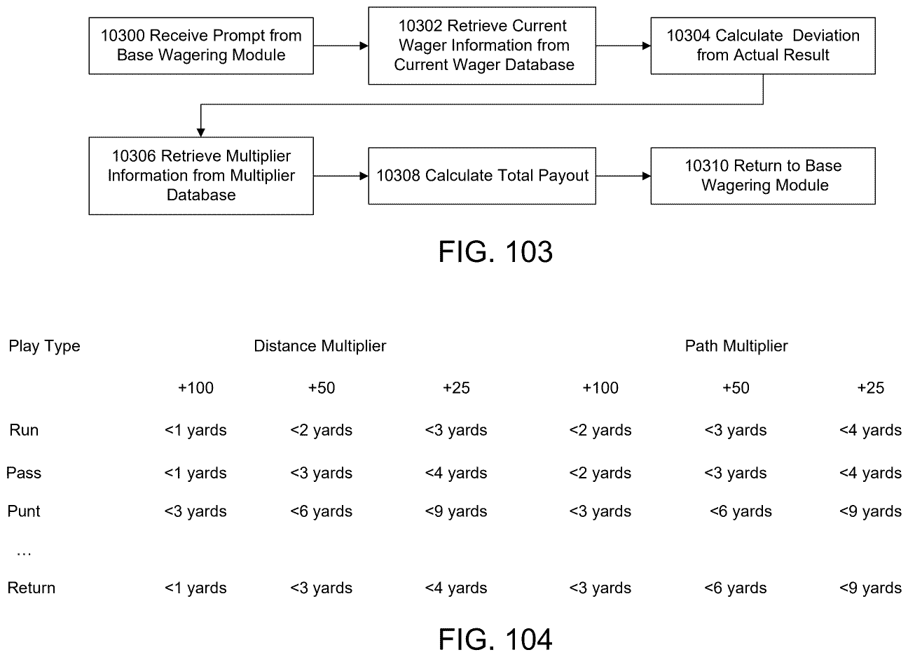

FIG. 103 illustrates a wager adjustment module, according to an embodiment.

FIG. 104 illustrates a multiplier database, according to an embodiment.

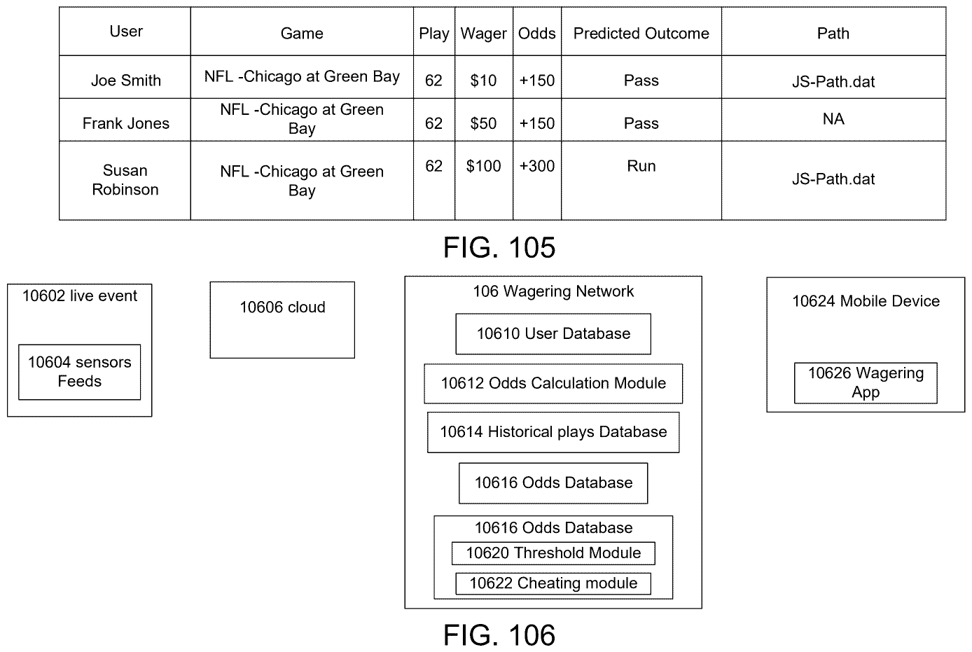

FIG. 105 illustrates a current wager database, according to an embodiment.

FIG. 100 displays a system for an AR VR In-Play Wagering System. This system includes a live event 10002, for example a sporting event such as a football game, basketball game, baseball game, hockey game, tennis match, golf tournament, eSports or digital game, etc. The live event can include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event, such as the score of American football or the run line in baseball, or a series of action in the live event. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live events in the future. Sportsbooks need to offer payment processing services in order to cash out customers. This can be done at kiosks at the live event or at another location.

Further, embodiments may include a plurality of sensors 10004 that may be used, such as motion sensors, temperature sensors, humidity sensors, cameras such as an RGB-D Camera which is a digital camera providing color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 10006 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance. The cloud may be communicatively coupled to wagering network 10008 which may perform real time analysis on the type of play and the result of the play. The cloud may also be synchronized with game situational data, such as the time of the game, the score, location on the field, weather conditions, and the like which may affect the choice of play utilized. For example, in other exemplary embodiments, the cloud may not receive data gathered from sensors and may, instead, receive data from an alternative data feed, such as SPORTSRADAR. This data may be provided substantially immediately following the completion of any play and the data from this feed may be compared with a variety of team data and league data based on a variety of elements, including down, possession, score, time, team, and so forth, as described in various exemplary embodiments herein.

Further, embodiments may include a wagering network 10008 which may perform real time analysis on the type of play and the result of a play or action. The wagering network 10008 (or cloud 10006) may also be synchronized with game situational data, such as the time of the game, the score, location on the field, weather conditions, and the like which may affect the choice of play utilized. For example, in other exemplary embodiments, wagering network 10008 may not receive data gathered from sensors and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein. The wagering network can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user.

Further, embodiments may utilize a user database 10010 which contains data relevant to all users of the system, which may include, a user ID, a device identifier, a paired device identifier, wagering history, and wallet information for each user.

Further, embodiments may include an odds calculation module 10012 which utilizes historical play data to calculate odds for in-play wagers.

Further, embodiments may utilize a historical plays database 10014 that contains play data for the type of sport being played in live event 10002. For example, in American football for optimal odds calculation, the historical play data should include meta data about the historical plays, such as time, location, weather, previous plays, opponent, physiological data, etc.

Further, embodiments may utilize an odds database 10016 that contains the odds calculated by the odds calculation module, and the multipliers for distance and path deviation, and is used for reference by the base wagering module 10018 and to take bets from the user through either the augmented reality device 10028 or through the virtual reality device 10030 and calculate the payouts to the user.

Further, embodiments may include a base wagering module 10018 that allows the user to place wagers on individual events in the live event 10002. The user may make a traditional wager on the event, such as wagering that the next play in an American football game will be a run instead of a pass. In this example the user is getting +150 odds on the run, meaning that for every $100 they wager, they will receive $150 if they win. The base wagering module 10018 can also allow users who are interfacing with the wagering network 10008 through an augmented reality (AR) device 10028, or a virtual reality (VR) device 10030, to add additional aspects to their wager. In this example the user could draw a path through the AR device 10028 or the VR device 10030, that designates the path and distance the running back will run on the play. These wagers can be made in a way in which the user may need to be correct on all of these aspects, such as in a parlay, or in a multiplier. In this example the multiplier is used in which the user has the base odds on the play, +150 for a run, then a multiplier for either or both of the distance of the play and the path the player takes. The user wagers on a run (+150), then draws a path off the right tackle and 10 yards past the line of scrimmage. The user will get an increase in their wager payout based on how close the actual play is to both the distance and the path the user predicted. The reality wagering module 10020 is called when the AR/VR user which will allow the user to draw or act out their prediction for the path of the play, and if the user wins the initial bet, for example a run versus a pass, the wager adjustment module 10022 is called to calculate how far from the total distance the user predicted the actual result is, and the average distance the actual play path was from the user predicted path. The resulting adjusted payout is then recorded in the wallet portion of the user database 10010.

Further, embodiments may include a reality wagering module 10020 through which the user can designate the wager they wish to make regarding the path of a participant or element of the live event 10002. Users can designate a wager in any of a variety of manners, for example through the use of a gesture interface, controller, or the movement of the user, the user demonstrates the path and distance they want to add to or parlay with their wager.

Further, embodiments may include a wager adjustment module 10022 through which the payout to users who have selected a path and distance to add to their wager are adjusted. The wager adjustment module 10022 is only called when the user wins their initial bet. In this example, the user selected a pass, so the wager adjustment module 10022 is only called by the base wagering module 10018 if the play was a pass. In this example the user selected pass, so the wager adjustment module 10022 will first determine how close the user's predicted distance is to the actual distance of the play. In this example the user had predicted that the pass play would travel ten yards past the line of scrimmage, and the actual play traveled eight yards past the line of scrimmage. In the present example, that means the user will get +50 added to their original payout odds, based on the multipliers in the odds database 10016, bringing their total from +150 to +200. The path of the play predicted by the user is then compared to the actual path of the play. The average distance between the predicted path and the actual path are then compared to the multipliers in the odds database 10016. In this example the predicted path was an average of 1.5 yards from the play path, resulting in the user getting +100 added to their original payout odds, bringing his total odds payout to +300 from the original +150. These adjustments are sent back to the base wagering module 10018 for the payout to made to the user's account.

Further, embodiments may utilize a multiplier database 10024 that is populated by the administrator of the wagering network, or by the odds calculation module 10012, in which the available wager multipliers are stored. In this example, two types of multipliers are used. The first is for the distance past the line of scrimmage the user predicts the play will travel and the second is the average distance the user's predicted path of the player, or element of the live event 10002, the actual path of the player or element takes on the play.

Further, embodiments may utilize a current wager database 10026 that is populated by the reality wagering module 10020 with the wager, including any multipliers the user has elected to wager upon.

Further, some embodiments include an augmented reality device 10028 that allows the user to have an interactive experience with the real-world environment of the live event 10002. There are numerous types of augmented reality devices 10028 that are known in the art including handheld devices such as smartphones and tablets, as well smart glasses, head mounted displays, smart contact lenses, virtual retinal displays, etc. Additional devices not listed could be used if they combine the real and virtual worlds and allow for real-time interaction between the two. There are methods known in the art for overlaying additional information on a live sporting event with an augmented reality device 10028, such as MLB at Bat.

Further, some embodiments include a virtual reality device 10030 that allows the user to have a simulated experience that allows for real-time interaction with the live event 10002. A virtual reality device 10030 is typically a head mounted display that provides the user with realistic images, sounds, and other sensations that simulates the user's physical presence in a virtual representation of the live event 10002. There are methods known in the art for integrating live sporting events into a virtual reality device, such as FOX Sports VR.

FIG. 101 illustrates the base wagering module 10018. The process begins with a user logging into the wagering network 10018, at step 10100. For users of either an AR device 10028 or a VR device 10030, the reality wagering module 10020 is prompted, at step 10102. The reality wagering module 10020 will continue to adjust the display of wagers on the AR device 10028 or the VR device 10030 based on the user's point of view until the user places a wager. That wager is received, at step 10104. The sensors 10004 are then polled, at step 10106 for the completion of the play wagered upon. For example, listening for the referee's whistle indicating the end of a play in an American football game. The actual result of the play compared, at step 10108 to the wagered upon result. It is determined, at step 10110 if the wager is won. If the wager is lost, the process goes to step 10114 to deduct the user's wager amount from their account balance in the user database 10010. If the wager is won, for example the pass was completed to the wide receiver the user predicted would catch the ball, the wager adjustment module 10022 is prompted, at step 10112. The total payout for the wager after determining if the user wagered on and/or won their multiplier bets, in this example multipliers for distance of the play and path of the wide receiver, is returned to the base wagering module 10018 from the wager adjustment module 10022. The user's account balance in the user database 10010 is updated, at step 10114 based on the original wager amount lost or the total payout won. If it is determined, at step 10116 that the live event 10002 is complete, the process will return to step 10102 and prompt the reality wagering module 10020 so as to receive additional wagers. When the live event 10002 is complete the program ends, at step 10118.

FIG. 102 illustrates the reality wagering module 10020. The process begins with receiving a prompt, at step 10200 from the base wagering module 10018 that the user of either an augmented reality device 10028 or a virtual reality device 10030, has logged into the wagering network 10008. The live event is rendered into a virtual space for the virtual reality device 10030, in one of the methods known in the art, such as FOX Sports VR, NextVR, and Oculus Quest. The reality wagering module 10020 then begins the process of integrating the display of wagers available through the wagering network 10008 with the live event 10002 by retrieving, at step 10202 the odds on currently open wagers from the odds database 10016. The AR device 10028 or VR device 10030 is then polled, at step 10204, to determine the user's point of view of the live event 10002. For example, two AR device 10028 users are viewing the same American football game from the stands. User Joe Smith is seated on the 50-yard line on the second deck, providing a clear view of the entire field. User Bob Jones is seated at field level in the end zone currently being defended by the defense. His point of view obscures several offensive players from his AR device 10028. The player(s) in the user's point of view are identified, at step 10206. The player(s) who are a party to at least one currently available wager is highlighted, at step 10208 on the AR device 10028 or VR device 10030. In this example there are five wagers currently available for the next play through the wagering network 10008. The first is on the Green Bay Packers' quarterback throwing for a first down, the second is on the Green Bay Packers' running back running for a first down, and the third, fourth and fifth available wagers are on which of the Green Bay Packers' two wide receivers, or the running back, will catch the ball for a first down. In this example user Joe Smith, who's point of view encompasses the entire field and all the players on it, all available wagers are displayed over their respective players on his AR device 10028. While user Bob Jones would only see the wagers available on the two Green Bay Packers wide receivers, that his AR device 10028 can see, and not the three available wagers on the quarterback and the running back, who are obscured from view by the defensive players. In another embodiment, the user of a VR device 10030 could move around on the field of play in and amongst the players. This would result in a constantly changing point of view that is polled for, at step 10210. Users of AR devices 10028 could also change their point of view during the live event 10002. This will result in the reality wagering module 10020 highlighting different players as the players move around the field and/or the user changes their point of view. This will continue until there is a player selection, at step 10212. Once a player is chosen, the available wagers are displayed, at step 10214. In this example the user Joe Smith is electing to wager that the Green Bay Packers wide receiver will catch the ball. That bet has +150 odds. User Joc Smith can make two additional wagers that will, in this example, result in multipliers to his payout. The first multiplier is the distance the play will travel. For example, user Joe Smith thinks the pass play will gain the Green Bay Packers eight yards. This distance predicted will be compared to the actual distance the play traveled, only if it is completed pass to the wide receiver selected, to determine if the user's payout is increased. The second multiplier is the average distance a path predicted by the user will be from the actual path a player will takes on that play. This path can be input by the user in a number of different methods that utilize the functionality of the AR device 10028 and VR device 10030. In this example, user Joe Smith is seated in the stands, at the fifty yard line, on the second tier, with a full view of the field and players, using his smartphone as an AR device 10028 to place in play wagers on the game through the wagering network 10008. He touches the wide receiver on his screen, selects his wager amount, and traces the path he predicts the wide receiver will take on his phone screen. If the user was utilizing a VR device 10030 they could, for example, run the route they predict the wide receiver will take from that position on the field. The user's wager selection is received, at step 10216. The user's selected wager is written, at step 10218 to the current wager database 10026. The base wagering module 10018 is prompted, at step 10220 that a user has made a wager.

FIG. 103 illustrates the wager adjustment module 10022. The process begins with receiving, at step 10300, a prompt from the base wagering module 10018 that a user has won a wager, along with the actual play results. The current wager information, including the odds and the path/distance specified by the user is retrieved, at step 10302 from the current wager database 10026. In this example, user Joc Smith believes the wide receiver number 88 will run an out route, in which the receiver runs straight down the field for a distance of ten yards then makes a right angle turn towards the sideline. The wagering network is offering +150 odds on the pass outcome, meaning if user Joe Smith wins his $10 bet, he will be paid back $15, before the multipliers for his path and distance selection are applied. The path taken by the receiver in the actual play result is identified, in this example through video of the play, is compared to the path user Joc Smith predicted. The receiver had the same starting point in both the actual play and user Joc Smith's predicted path. In both the predicted path and the actual play, the wide receiver ran vertically upfield and made a left turn towards the sideline. The wide receiver made the left turn towards the sideline eight yards upfield. The deviation of the predicted path from the actual result, is calculated, at step 10304. The deviation between the actual path and the predicted path could be compared in many different ways and be linked to one or more types of wager multipliers. In this embodiment the wagering network 10008 is offering two multipliers for users of augmented reality devices 10028 and virtual reality devices 10030. One is the distance the play travels, and the second is the average distance the actual play deviated from the path predicted by the user. Those multipliers are retrieved, at step 10306. The user Joc Smith had predicted that the pass play would travel ten yards past the line of scrimmage, and the actual play traveled eight yards past the line of scrimmage. In the present example, that means the user will get +50 added to their original payout odds, based on the multipliers in the multiplier database 10024. The path of the play predicted by the user is then compared to the actual path of the play. The total payout is calculated, at step 10308, when the average distance between the predicted path and the actual path are then compared to the multipliers in the multiplier database 10024. In this example the predicted path was an average of 1.5 yards from the play path, resulting in the user Joe Smith getting +100 added to their original payout odds. The total payout to user Joe Smith is his $10 initial wager times his new odds total of +300 (original +150 plus +50 for the 2 yard difference in play length and plus +100 for the average distance between the predicted and actual path) is $30 on top of his initial wager. Once the payout is calculated that information is sent, at step 10310 to the base wagering module 10018.

FIG. 104 illustrates the multiplier database 10024. The multiplier database 10024 contains the wager multipliers available to AR and VR users of the wagering network 10008. The reality wagering module 10020 allows users to specify the path of the ball/player as an addition to a wager on the outcome of a single play. For example, in an American football game the user can wager that the next play will be a pass or a run. If, for example, the user wagered that the next play was going to be a run, they can also input through either the AR device 10028 or the VR device 10030 the path of the running back will carry the ball. The multiplier database 10024 is used by the wager adjustment module 10022 to increase the payout to the user if they predicted a path/distance, and they are under the multiplier thresholds. There are different thresholds for each play type, run, pass, etc., and each play type has multiple thresholds. For example, if the user predicted a pass of 10 yards and the actual distance of the pass was 8 yards, the user would get +50 added to their original wager odds for being less than 3 yards away from the actual distance of the play. Further, the user predicted the route of the wide receiver who catches the ball, but could also have predicted the flight path of the ball, and actual route of the wide receiver was an average of 1.5 yards from the path predicted by the user, the user gets an additional +100 added to their wager payout based on being less than 2 yards away from the path on average.

FIG. 105 illustrates the current wager database 10026. The database contains current wagers made through the base wagering module 10018 that have not yet been resolved. For example, in an American football game between the Chicago Bears and the Green Bay Packers, three users have made a wager on the 67th play of the game, where the Packers have the ball on the Bears 40 yard line, 3rd down and 7 with 5:15 remaining in the fourth quarter. Two of the three users think the next play will be a passing play, and two of the three users have elected to specify the route and distance a player will travel. User Joe Smith believes the wide receiver number 88 will run an out route, in which the receiver runs straight down the field for a distance of ten yards then makes a right angle turn towards the sideline. The wagering network is offering +150 odds on the pass outcome, meaning if user Joe Smith wins his $10 bet, he will be paid back $15, before the multipliers for his path and distance selection are applied. Frank Jones also believes the play will result in a pass but has elected not to select a path or distance to be eligible for multipliers on his wager. User Frank Jones wagered $50 on this outcome at +150 odds, meaning he will win $75 if the actual play results match his wager. User Susan Robinson believes the play will be a run and has specified a route distance the that will be traveled by the running back number 23. The +300 odds on this outcome mean that user Susan Robinson will be paid out $300 on her $100 wager if the actual outcome matches her wager. The path specified by the user is stored as a datafile in this example so as to allow the wager adjustment module to compare the path specified by the user to the path taken by the player or ball in the actual play. Once a play is completed and the result of the play is compared to all current wagers and the account balance of each user who wagered on the play is updated based on the result of the play, the user's wager and the odds on that wager. The database content is then cleared or archived in a database of prior wagers that is kept for auditing purposes.

FIG. 106 illustrates a system for tracking user bets to ensure compliance, according to an embodiment.

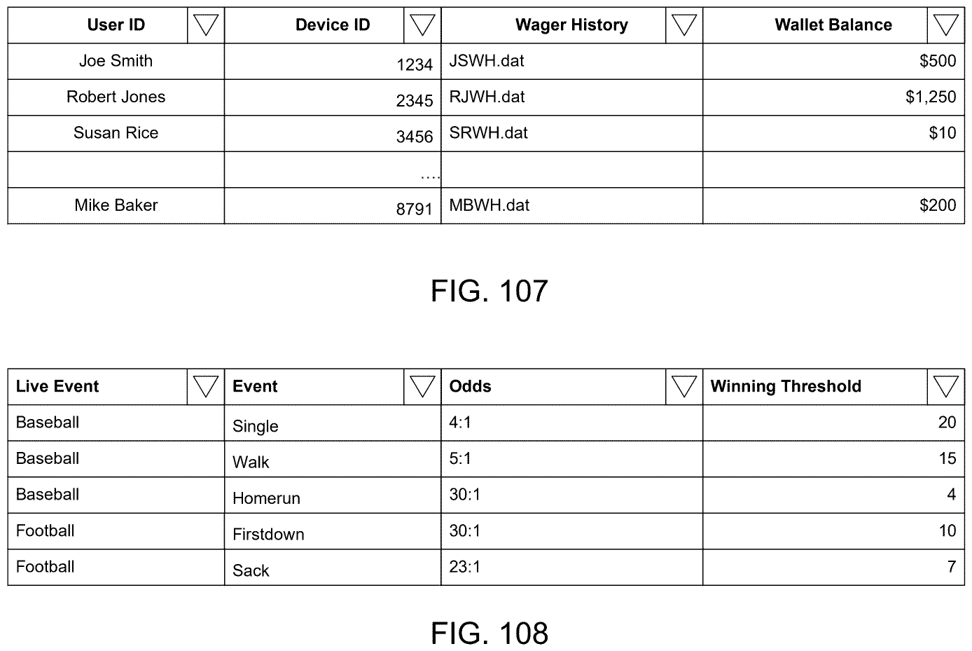

FIG. 107 illustrates a user database, according to an embodiment.

FIG. 108 illustrates an odds database, according to an embodiment.

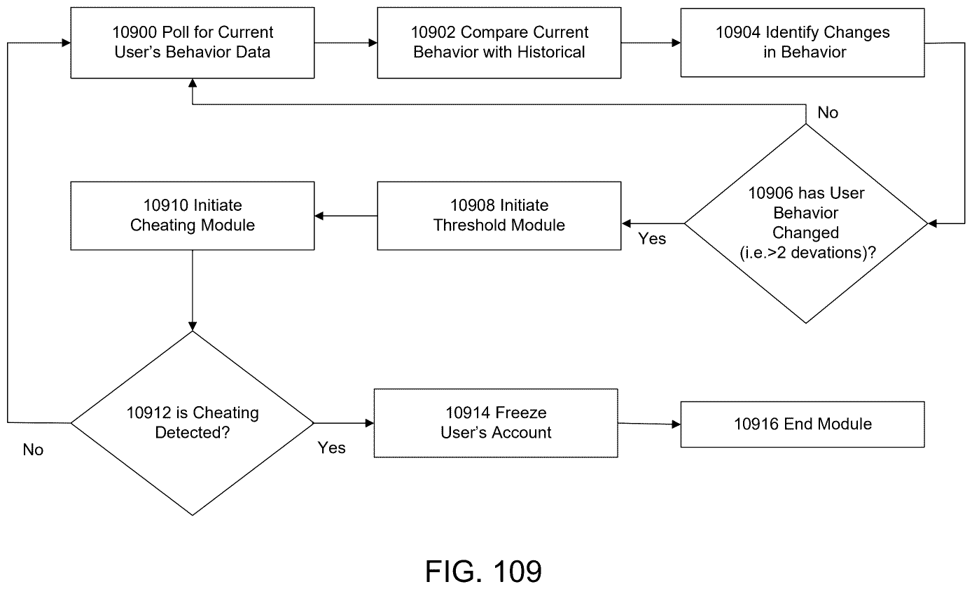

FIG. 109 illustrates a user behavior module, according to an embodiment.

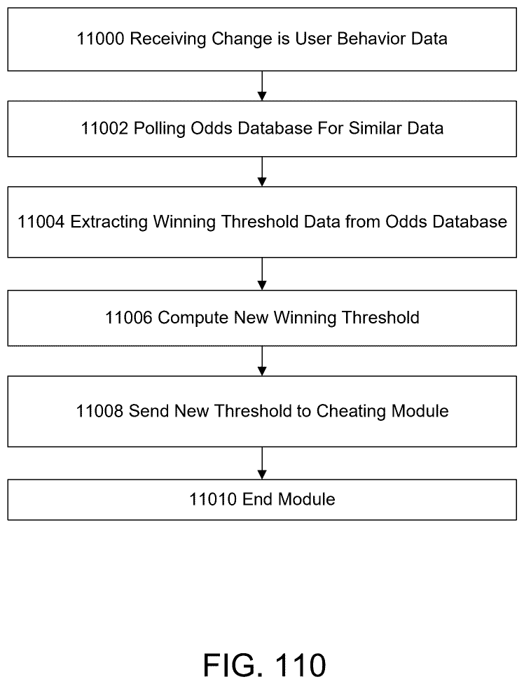

FIG. 110 illustrates a threshold module, according to an embodiment.

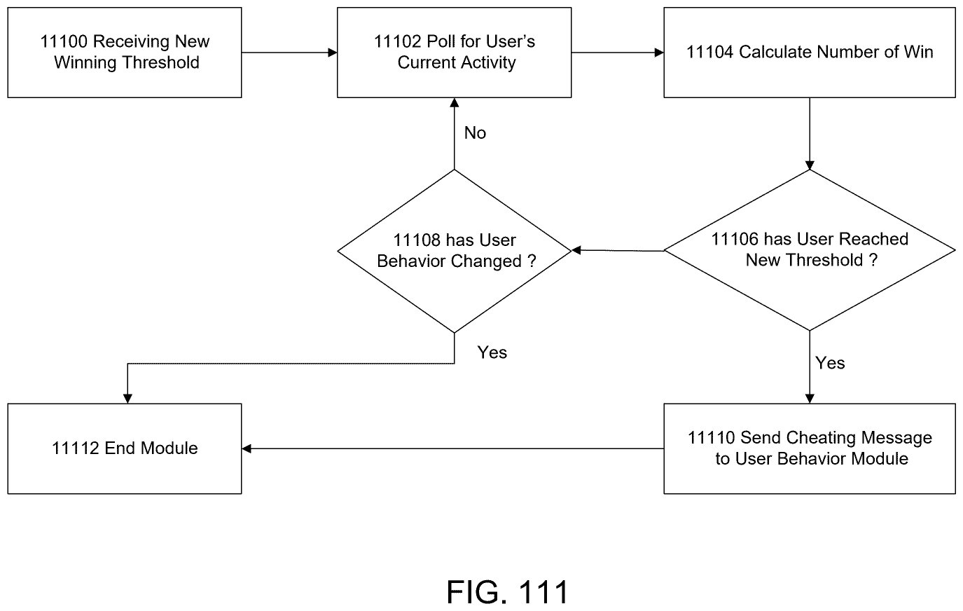

FIG. 111 illustrates a cheating module, according to an embodiment.

FIG. 106 is a system for tracking user bets to ensure compliance. The system may include a live event 10602, for example a sporting event such as a football game, basketball game, baseball game, hockey game, tennis match, golf tournament, eSports or digital game, etc. The live event 10602 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 10602, such as the score of American football or the run line in baseball, or a series of action in the live event 10602. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live events 10602 in the future. Sportsbooks need to offer payment processing services in order to cash out customers. This can be done at kiosks at the live event 10602 or at another location.

Further, embodiments may include a plurality of sensors 10604 that may be used such as motion sensors, temperature sensors, humidity sensors, cameras such as an RGB-D Camera which is a digital camera capable of capturing color (RGB) and depth information for every pixel in an image, microphones, radiofrequency receiver, a thermal imager, a radar device, a lidar device, an ultrasound device, a speaker, wearable devices etc. Also, the plurality of sensors 10604 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball. In this system only the video feed is used, but in other embodiments additional sensor data can be used to augment the accuracy of the probabilistic engine.

Further, embodiments may include a cloud 10606 or communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the Internet and relies on sharing of resources to achieve coherence and economics of scale, like a public utility, while third-party clouds enable organizations to focus on their core businesses instead of expending resources on computer infrastructure and maintenance. The cloud may be communicatively coupled to wagering network 108 which may perform real time analysis on the type of play and the result of the play. The cloud 106 may also be synchronized with game situational data, such as the time of the game, the score, location on the field, weather conditions, and the like which may affect the choice of play utilized. For example, in other exemplary embodiments, the cloud may not receive data gathered from sensors and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various exemplary embodiments herein.

Further, embodiments may include a wagering network 10608 which may perform real time analysis on the type of play and the result of a play or action. The wagering network may also be synchronized with game situational data, such as the time of the game, the score, location on the field, weather conditions, and the like which may affect the choice of play utilized. For example, in other exemplary embodiments, wagering network 10608 may not receive data gathered from sensors and may, instead, receive data from an alternative data feed, such as Sports Radar. This data may be compiled substantially immediately following the completion of any play and the data from this feed may be compared with a variety of team data and league data based on a variety of elements, including down, possession, score, time, team, and so forth, as described in various exemplary embodiments herein. The wagering network can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may include a user database 10610 which contains data relevant to all users of the system, including but not limited to, a user ID of the user, a device identifier, a paired device identifier, wagering history, and wallet information for the user. For example, a user's wager history may include a file that has the types of live event 10602 and events within the live event 10602 that the user wages on including the amount they waged, the odds for the wager, and the amount they won or lost.

Further, embodiments may include an odds calculation module 10612 which utilizes historical play data, as well as the 3rd party network's 10622 analytics, to calculate odds for in-play wagers.

Further, embodiments may include a historical plays database 10614, that contains play data for the type of sport being played in live event 10602. Further, embodiments may include a historical plays database 10614, that contains play data for the type of sport being played in live event 10602. In one embodiment, for optimal odds calculation, the historical play data should include metadata about the historical plays, such as time of the live event 10602, location, weather, previous plays, opponent, physiological data of the players (including blood pressure, pulse rate, and respiration rate), batting average of all players, information related to the players such as injuries in the past, batting average, earned run average, catch probability, spin rate, launch angle, exit velocity, information related to trainers of each player, etc. For example, in the baseball game, information stored in the historical plays database 10614 may include information related to the previous baseball games played by a specific team or player, such as, but not limiting to, the weather condition, i.e. during the match, it was cloudy.

Further, embodiments may include an odds database 10616 that contains the odds calculated by the odds calculation module and is used to display the odds on the mobile device 10624, and to take bets from the user through the mobile device wagering app 10626. Furthermore, the odds database 10616 contains data for winning thresholds for cutting users betting off if they start winning too much. Winning thresholds can be determined based on odds of winning. For example, an event where the user is more likely to win would have a higher threshold as it would be expected for a user to win more often.

Further, embodiments may include a user behavior module 10618 that analyzes a user's behavior by comparing the user's current betting habits or patterns with historical user data from the user database 10610. If a change is detected in the user's betting behavior or pattern, the threshold module 10620 and cheating module 10622 are initiated. There are several methods that can be used to determine the change in a user's behavior, for example, users betting habits such as how often, time of day, type of sporting events, type of event, wager amounts, and winning or losses. These data points are then plotted, and a normal distribution or trends can be calculated. Deviation from the normal distribution or trend can then be determined based on a user's current behavior. Other methods are also well known in user behavior monitoring such as pattern matching. For example, a user may have the habit of wagering on a baseball game and events in that game. The user may only bet on if a batter will get a single or walk and usually wagers between $3 and $5 per wager. A change in the user's behavior may be detected if the user starts only wagering on batters striking out and batters getting home runs while also increasing his wager amount. It would be obvious that the user has deviated from his typical behavior. Now if a user only changes is wager on occasion the calculated and plotted deviation would not be enough to trigger a user's change in behavior.

Further, embodiments may include a threshold module 10620 determines a user's new winning threshold when a user's betting behavior or pattern changes. The threshold module 10620 looks at the current user's behavior, compares it to the similar behavior in the odds database 10616, extracts the normal winning threshold for the behavior and then discounts the threshold based on the odds. For example, if a user's pattern of betting changes to a new betting event with higher odds compared to the user's normal habits, they the threshold for winning may be reduced by 50%. For example, if a typical winning threshold for wagering on if a batter in a baseball game will strike out is say 10 within a game. The threshold module 10620 would reduce this by 50% to 5 wager wins during the baseball game while wagering on strikeouts.

Further, embodiments may include a cheating module 10622, that monitors a user's winnings and compares the user's wins to the updated threshold determined by the threshold module 10620. If a user exceeds the updated threshold the user's betting is halted. For example, if a user's changes their behavior from wagering on a batter in a baseball games getting a single to striking out and they end up winning 5 wagers. The system would freeze or halt the user's account preventing them from any further bets.

Further, embodiments may include a mobile device 10624 such as a computing device, laptop, smartphone, tablet, computer, smart speaker, or I/O devices. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allow for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also allow storage and/or an installation medium for the computing device. In still other embodiments, the computing device may allow USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In the embodiments the user device could be an optional component and would be utilized in a situation in which the paired wearable device is utilizing the user device as additional memory or computing power or connection to the internet.

Further, embodiments may include a wagering app 10626, which is a program that enables the user to place bets on individual plays in the live event 10602, and display the audio and video from the live event 10602, along with the available wagers, and statistical and analytical overlays on either the user's mobile device 10624. The wagering app 10626 allows the user to interact with the wagering network in order to place bets and allow payment/receive funds based on wager outcomes.

FIG. 107 illustrates the user database 10610. The database contains information about all of the users of the wagering network 10608. This information includes, but is not limited to, a user identification, which is the user's name in this example but could also be any other kind of alphanumeric identification or other form identification. A device identification, for the mobile device 10624 on which the wagering app 10626 is installed. The user's wager history, which is a data file in this example, can be accessed or stored in association with wagering app 10626. The user's current wallet/account balance may also be provided, in this example the balance is in US dollars, but the system could use other currencies or non-monetary prizes such as points.

FIG. 108 illustrates the odds database 10616. The odds database 10616 contains the odds calculated by the odds calculation module, and is used to display the odds on the mobile device 10624, and to take bets from the user through the mobile device wagering app 10626. Furthermore, the odds database 10616 contains data for winning thresholds for cutting users betting of if they start winning too much. Winning thresholds can be determined based on odds of winning. For example, an event where the user is more likely to win would have a higher threshold as it would be expected for a user to win more often.

FIG. 109 illustrates the user behavior module 10618. The user behavior module 118 begins with the polling, at step 10900, for current user behavior data. The current user behavior data can be polled directly from the user's device, in this case the mobile device 10624 or by looking at current user data in the user database 10610. Current behavior data can be defined different ways depending on how the system is configured. For example, current behavior could be any behavior in the last 24 hours or could just be related to the current live event 10602. For example, the current user data may include current event, what they are wagering on, the odds, and amount. Current user behavior data may only be relevant to a single live event 10602 which the user is currently wagering on. Once the current user's behavior data is received, it is compared, at step 10902 to the user's historical behavior data. There are several ways of comparing user behaviors, for example, the current and historical user behavior data are plotted, and trends or normal distributions are calculated. These plots are then compared for changes in behavior. Furthermore, a user may have the habit or pattern of only wagering on baseball games, while only wagering on if a batter will get a single or walk. This is the user's historical wager pattern or behavior. Changes in the current and historical data are then compared and any changes are identified, at step 10904. For example, the historical behavior data may be plotted and normal distribution or trends may be calculated. The same may be done with the current data and the two are compared, at step 10906. If the current data is more than two deviations outside historical data, then it can be determined that there is a change in behavior. For example, a user's average wager size $50, and the standard deviation of their wagers is $15. A wager over $80 would be indicative of a change in behavior. The average odds of the user's wagers could also be used as a metric in this fashion. For example, if the user's average wager is at +110 odds, with a standard deviation of +20. This would be consistent with a user that does not take big risks, nor bet on heavy favorites, so if they were to start placing wagers at +250 odds, that would be indicative of a change of behavior. In other embodiments the time in game, or user account balance, or previous wagers, could be considered for user behavior mapping. Embodiments could employ regression analysis on the user's wager size relative to the inning the wager is placed during in a baseball game. In such an embodiment a user may have escalating average wager size as a game goes on, such as $10 average wager in the first inning, $20 in the third inning and $30 from the sixth inning on. This type of pattern would need to have a coefficient of determination, denoted R², above a threshold set by a system administrators to be considered a behavior pattern. R² is a statistical measure of how close the data points are to a fitted regression line. The closer R² values are to 1, the closer the data points are the fitted regression line. For example, if that trendline of the user's wagers against the inning of the wager has an R² of 0.15, the inning is not correlated to the wager size. Whereas if the user's average wager size has an R² over 0.90, their wager size is highly correlated to the inning in which the wager is placed. There are also methods of behavior pattern matching that can be used as well and are well known. For example, a user who normally has a history of only wagering on baseball games, and primarily on if a batter will get a single or walk and only wagers an amount between $3 and $5. This data could be plotted, and a normal distribution of the user's pattern calculated. When the user begins to wager on other events or changes the amounts that are wagered, these new wagers will not fall within a normal curve of activity. Now, on occasion, a user may change habits and make an outlying wager. But one outlying wager outside normal patterns will not trigger a change in user behavior as the system would be looking at larger patterns and one event would not account for enough deviation from the norm. As previously discussed, once a change in user behavior is identified, it is then determined how much. Continuing the current example, it would determine if the behavior is more than 2 deviations outside normal historical behavior. If a change is not more than 2 deviations the system returns to step 10900 and continues to poll for current user behavior data. If a change greater than 2 deviations from historical patterns is identified, the user behavior module 10618 then initiates, at step 10908, the threshold module 10620. For example, if a user starts wagering on homeruns in a baseball game rather than the historical normal pattern of wagering on singles and walks. Furthermore, the user behavior module 10018 also initiates, at step 10910 the cheating module 10022. The user behavior module 10018 then waits for the cheating module 10622 to determine, at step 10912 if the user is cheating. If there is not cheating detected the user behavior module 10018 returns to poll for current user's behavior data 10600. Alternatively, the user behavior module 10618 may not wait for the cheating module 10622 to determine if the user is cheating or not, but rather after a predetermined length of time reset and begin polling for the current user's behavior data. If cheating is detected the user behavior module 10618 will automatically freeze or deactivate the user's account at step 10914. The user behavior module 10618 will end, at step 10916 once the user's account is frozen or deactivated.

FIG. 110 illustrates the threshold module 10620. The threshold module is initiated, at step 11000, by the user behavior module 10618 when a change in a user's behavior is detected and the threshold module 10620 receives from the user behavior module 10618 data associated with the user's change in behavior. For example, the change in user behavior may be the fact the user is now wagering on homeruns in a baseball game rather than the user's normal behavior of singles or walks. The odds database 10616 is then polled, at step 11002 for data similar to the data received from the user behavior module 10618. For example, if the user typically only bets on event “a” but has changed behavior to betting on event “b”, the change in the user's behavior is betting on event “b”. The threshold module 10620 would then look for relevant data to event “b” in the odds database 10616. Typically, if a user typically wagers on singles in a baseball game but then start wagering on homerun, the winning threshold would then be extracted from the odds database 10616. The threshold module 10620 then extract, at step 11004 from the odds database 10616 the winning threshold for the new event the user is now betting on that aligns with the user's change in betting behavior. The winning threshold is a threshold often used to prevent a user from winning too much. It is often set at a level at which a user could only obtain by possibly cheat. Once the winning threshold is extracted, a new threshold is calculated at step 11006. The purpose for calculating a new threshold is to lower the normal threshold when a user's behavior changes. The general idea is that if a user's behavior changes it may be due to cheating. Not changing the threshold would allow the user to still win a significant amount because the threshold is still high. Furthermore, a user changing habits most likely would not win as much as they are betting on new events, they are not familiar yet. Reducing the threshold would help identify and shut down cheating sooner. The new winning threshold could be calculated by reducing it by a certain percentage or using other forms of calculations. For example, reducing the threshold by 50%. One reason for reducing the winning threshold by a percentage would be due to the fact that winning thresholds will be different for different events depending on their odds. An event with much higher odds and more unlikely to win would have a lower threshold. For example, if the change in a user's behavior is that they are now wagering on homerun and the typical winning threshold for homeruns is 4, then the threshold module 10620 would calculate the new homerun winning threshold as 2 reducing the original threshold by 50%. The new calculated winning threshold is then sent, at step 11008 to the cheating module 10622. Once the new winning threshold is calculated and sent to the cheating module 10622 the threshold module 10620 ends at step 11010.

FIG. 111 illustrates the cheating module 10622. The cheating module 10622 begins by receiving, at step 11100 from the threshold module 10620, the new calculated threshold for the user's change in behavior. The cheating module 10622 then polls, at step 11102 for the user current activity directly from the user database 10610 or could get it directly from the user behavior module 10618. For example, the user data the cheating module 10622 would poll for is the wager amounts, how much total the user has won or lost and the number of times a user has won or lost. The number of wins by the user since their change in behavior is then calculated at step 11104. This can be done by counting or summing the number of times the user had won. In some instances, the user total winnings may need to be calculated rather than the number of times they win depending on how the winnings threshold is determined. In one embodiment the winning threshold may be the number of times a user wins while in another embodiment the winning threshold depends on the total amount of money won by the use. It is also possible that the winning threshold could be a combination of both the number of wins and the total amount of money won. If the user has not reached the new winning threshold the cheating module 10622 determines, at step 11106 if the user's behavior has changed or the live event has ended. If the user has not reached the new winning threshold and their behavior had not changed the cheating module returns to step 11102 to continue to monitor the user's winning at step 11104. If the user's behavior has changed, or the live event 10602 had ended then they module ends, at step 11112. For example, if a baseball games ends in which a user's habits change then the module would end as the user's activity for that event has ended or if a user's behavior goes back to their original pattern or only wagering on singles and walks rather than homeruns. If, in step 11106, the user has reached the new winning threshold, a message is sent to the user behavior module 10618 at step 11110. This message will let the user behavior module 10618 that the user is possibly cheating, and it will halt any more bets from the user and freeze their account. The cheating module 10622 ends if the user reaches the new winning threshold or if it is determined that the user's behavior changed or the live event 10602 ended.

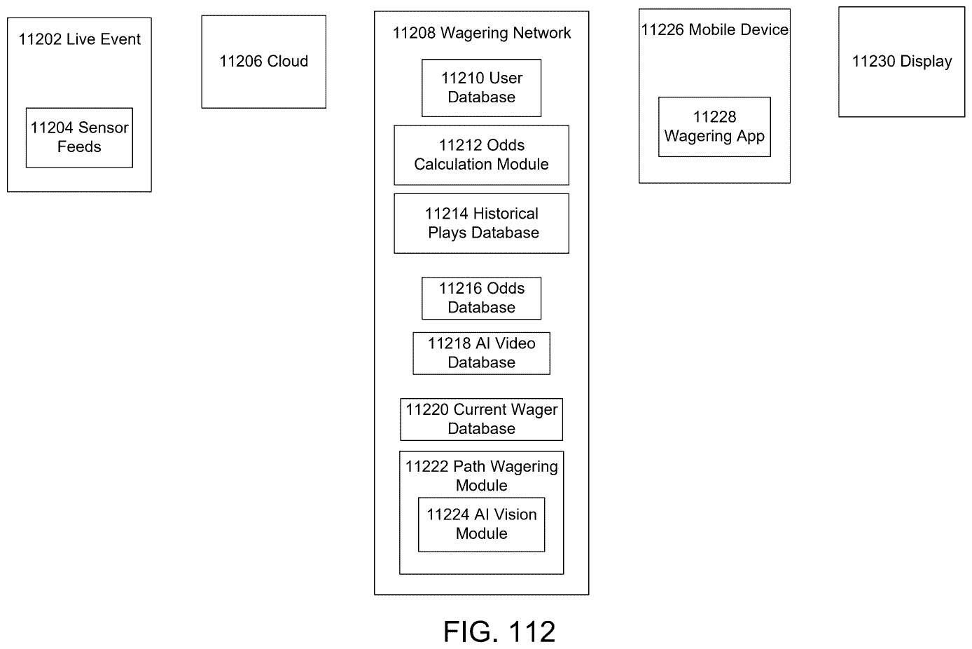

FIG. 112 illustrates a system for an AI-based path wagering, according to an embodiment.

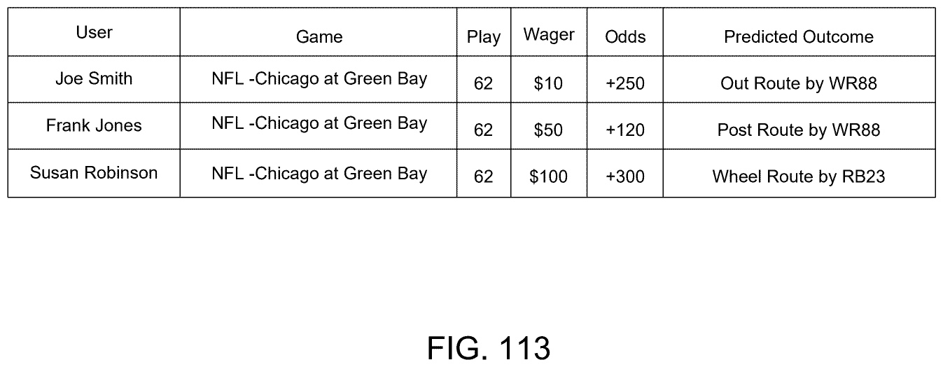

FIG. 113 illustrates a current wager database, according to an embodiment.

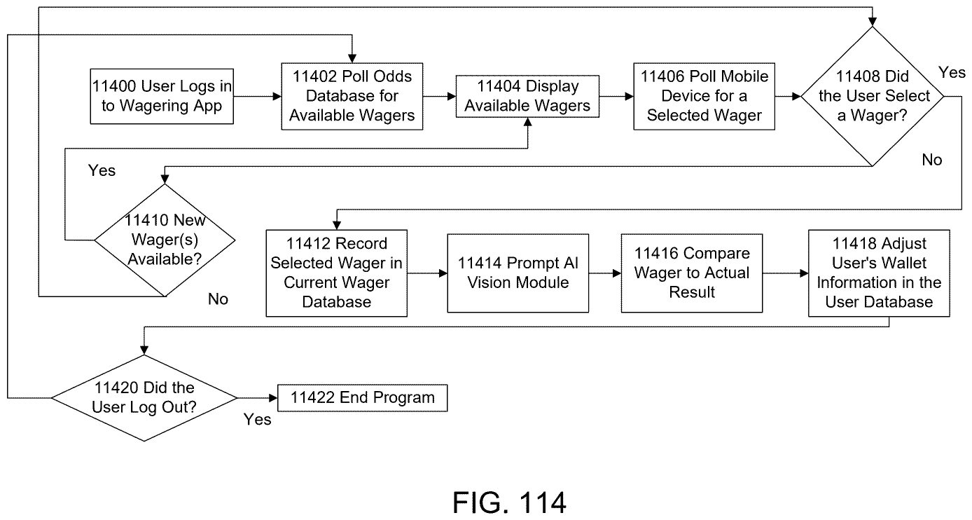

FIG. 114 illustrates a path wagering module, according to an embodiment.

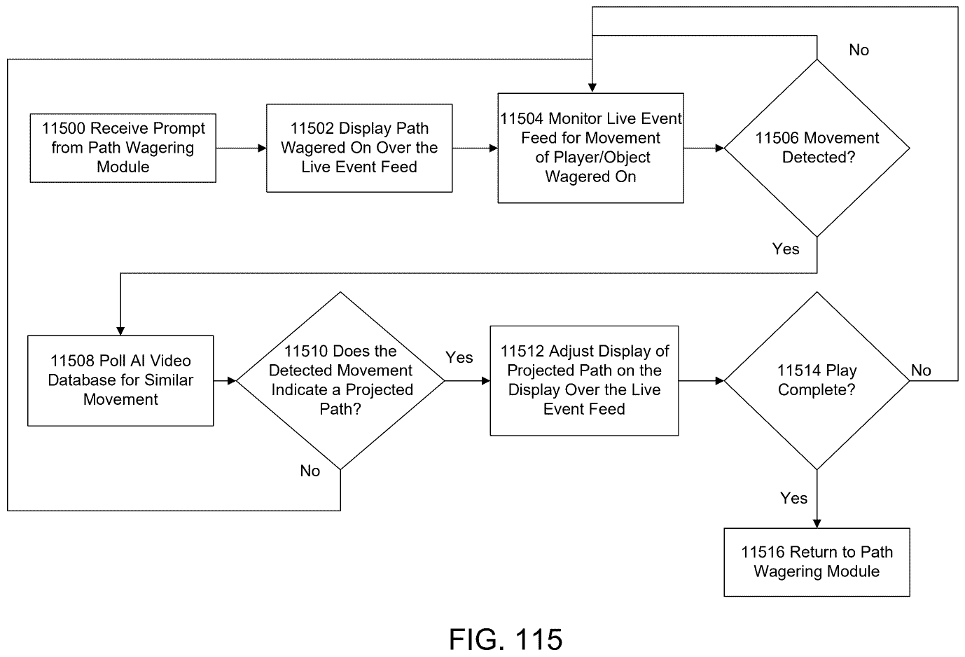

FIG. 115 illustrates an AI vision module, according to an embodiment.

FIG. 112 is a system for an AI-based path wagering. This system may include a live event 11202, for example a sporting event such as a football game, basketball game, baseball game, hockey game, tennis match, golf tournament, eSports, or digital game, etc. The live event 11202 will include some number of actions or plays, upon with a user or bettor or customer can place a bet or wager, typically through an entity called a sportsbook. There are numerous types of wagers the bettor can make, including, but not limited to, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets, that are added games, that often allow the user to customize their betting, by changing the odds and payouts they receive on a wager. Certain sportsbooks will allow the bettor to buy points to move the point spread off of the opening line; this will increase the price of the bet, sometimes by increasing the “juice”, “vig”, or hold that the sportsbook takes. Another type of wager the bettor can make is an over/under, in which the user bets over or under a total for the live event 11202, such as the score of an American football game or the run line in baseball, or a series of plays in the live event 11202. Sportsbooks have a number of bets they can handle, which can be a limit of wagers they can take on either side of a bet before they will move the line or odds off of the opening line. Additionally, there are circumstances, such as an injury to an important player (such as a listed pitcher), in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live events in the future. Sportsbooks further need to offer payment processing services in order to cash out customers. This can be done at kiosks at the live event 11202 or at another location.

Further, a plurality of sensors 11204 that may be used such as motion sensors, temperature sensors, humidity sensors, cameras such as an RGB-D Camera which is a digital camera capturing color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play, and the like. Imaging devices may also be used as tracking devices such as player tracking that compiles statistical information through real-time X, Y positioning of players and X, Y, Z positioning of the ball. In this embodiment only the video feed is used, but in other embodiments additional sensor data can be used to augment the accuracy of the probabilistic engine (See, eg., Memory Augmented Deep Generative models for Forecasting the Next Shot Location in Tennis, Fernando et. Al, which is incorporated by reference herein in its entirety).

Further, a cloud 11206 or communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, and other communication techniques known in the art. The communication network may allow ubiquitous access to shared pools of configurable system resources and higher-level services that can be rapidly provisioned with minimal management effort, often over the Internet and relies on sharing of resources to achieve coherence and economics of scale, like a public utility, while third-party clouds enable organizations to focus on their core businesses instead of expending resources on computer infrastructure and maintenance. The cloud 11206 may be communicatively coupled to wagering network 11208 which may perform real time analysis on the type of play and the result of the play. The cloud 11206 may also be synchronized with game situational data, such as the time of the game, the score, location on the field, weather conditions, and the like, which may affect the choice of play utilized. For example, in other exemplary embodiments, the cloud 11206 may not receive data gathered from sensors and may, instead, receive data from an alternative data feed, such as SPORTRADAR. This data may be compiled substantially immediately following the completion of any play and the data from this feed may be compared with a variety of team data and league data based on a variety of elements, including down, possession, score, time, team, and so forth, as described in various exemplary embodiments herein.

In a further embodiment, a wagering network 11208, may perform real time analysis on the type of play and the result of a play or action. The wagering network 11208 (or cloud 11206) may also be synchronized with game situational data, such as the time of the game, the score, location on the field, weather conditions, and the like which may affect the choice of play utilized. For example, in other exemplary embodiments, wagering network 11208 may not receive data gathered from sensors and may, instead, receive data from an alternative data feed, such as SPORTRADAR. This data may be compiled substantially immediately following the completion of any play and the data from this feed may be compared with a variety of team data and league data based on a variety of elements, including down, possession, score, time, team, and so forth, as described in various exemplary embodiments herein. The wagering network can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can create engaging promotions to the user.

Further, an embodiment may utilize a user database 11210 which contains data relevant to all users of the system, which may include a user ID, a device identifier, a paired device identifier, wagering history, and wallet information, among other information, for the user.

Further, the embodiments can utilize an odds calculation module 11212 which utilizes historical play data to calculate odds for in-play wagers.

Further, a historical plays database 11214 that contains play data for the type of sport being played in live sporting event 11202 may be utilized in the embodiment. For example, in American Football, for optimal odds calculation, the historical play data should include meta data about the historical plays, such as but not limited to, time, location, weather, previous plays, opponent, physiological data, etc.

Further, embodiments may utilize an odds database 11216 that contains the odds calculated by the odds calculation module 11212. The odds database is used for reference by the path wagering module 11222 to display the odds on either the user's mobile device 126 or a secondary display 11230, and to take bets from the user through the mobile device 11226 wagering app 11228. The embodiments may also include an AI video database 11218 that stores historical video of players involved in the current live event 11202, and that is used by the AI vision module 11224, to predict the path of a player or object in the field of play. In an example where the user is wagering on the path of a pass catcher in an American football game, the database will have video of the potential pass catchers running routes in past games, or past plays from the current live event 11202. The AI vision module 11224, for example such as the tennis shot predictor described in Memory Augmented Deep Generative models for Forecasting Next Shot Location in Tennis (Fernando et al.) will then use this data to identify similar movements in the live event video feed to predict the path the pass catcher will take. Further, in the embodiments, it may be understood that only certain players in a live event may be subject to path wagers. In the example above, potential pass catchers are used. A further example could use both path catchers and running backs, but may exclude other players, for example offensive linemen, as desired.

Further, a current wager database 11220 that stores the wagers made on the current play in the live event 11202, to be used by the AI vision module 11224 to adjust the display of the live event 11202 on either the user's mobile device 11226 or a secondary display 11230.

Further, a path wagering module 11222 then displays available wagers from the odds database 11216 on either the user's mobile device 12226 or their display 11230. Next, a wager can be collected from the user and recorded in the current wager database 11220. The recording of the wager in the current wager database 11220 can prompt the AI vision module 11224 to adjust the display of the live event 11202 to include the user's wagered upon path as well as the predicted path, with the predicted path changing in appearance to indicate the level of confidence the AI has in the predicted path, and monitor for the completion of the play. Once the play is completed, the path wagering module 11222 compares the actual result of the play to the wagered upon result and updates the account balance of the user in the user database 11210. This continues for every play until the live event 11202 is over, the user closes the wagering app 11228, or some other action is taken where further updates are not necessary.

Further, in some embodiments the AI vision module 11224 compares video of the live event 11202 to historical video in the AI video database 11218 in order to project the path of a player or object in the field of play. In this example, the module is projecting the route of potential pass catchers in an American football game, for example a post route, go route, out route, wheel route, etc. The projected route is overlaid on live event 11202 video on the display 11230 or mobile device 11226 of the user as the projected route and the module's confidence in its prediction change. This continues to loop until the play is completed, at which point the path wagering module 11222 is prompted by the AI vision module 11224.

Further, a mobile device 11226, such as a computing device, laptop, smartphone, tablet, computer, smart speaker, or other I/O devices, may be utilized as a wagering platform. I/O devices may be present in the computing device. Input devices for inputting data or wagers may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors, and the like. Output devices, which may be used to output data to a user, may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices are capable of facial recognition which may be utilized as an input for different purposes including authentication and other commands. Some devices allow for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also offer storage and/or an installation medium for the computing device. In still other embodiments, the computing device may offer USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In the embodiments the user device could be an optional component and would be utilized in a situation in which the paired wearable device is utilizing the user device as additional memory or computing power or connection to the internet.

Further, a wagering app 11228, which is a program that enables the user to place bets on individual plays in the live event 11202, as well as display the audio and video from the live event 11202, along with the available wagers, and path overlays, on either the user's mobile device 11226 or their display 11230. The wagering app 11228 allows the user to interact with the wagering network 11208 in order to place bets and transact funds based on wager outcomes.

Further, a display, such as a television, smartphone, tablet, gaming system, etc., on which the live event 11202, along with the available wagers, and path overlays can be displayed, may be utilized.

FIG. 113 provides an illustration of the current wager database 11220. The database contains current wagers made through the mobile device 11226 wagering app 11228 that have not yet been resolved. For example, in an embodiment of an American football game between the Chicago Bears and the Green Bay Packers, three users have made a wager on the 67th play of the game, the Packers have the ball on the Bears' 40 yard line, and it is 3rd down and 7 with 5:15 remaining in the fourth quarter. Each user has inputted an indication that the next play will be a passing play and have utilized the path wagering module 11222 to wager on the exact route a player will run on the pass play. User Joe Smith believes the wide receiver number 88 will run an out route, in which the receiver runs straight down the field for a distance then makes a right angle turn towards the sideline. The wagering network 11208 is offering +250 odds on this outcome, meaning if user Joc Smith wins his $10 bet, he will be paid back $25. User Frank Jones also believes the play will result in a pass to wide receiver number 88 but thinks that the receiver will run a post route, in which a receiver runs straight down the field towards the goalpost. User Frank Jones wagered $50 on this outcome at +120 odds, meaning he will win $60 if the actual play results match his wager. User Susan Robinson also believes the play will be a pass, but is wagering that it will be a wheel route, in which the player runs out of the backfield towards the sideline and then turns upfield to receive the pass, run by the running back number 23. The +300 odds on this outcome indicate that user Susan Robinson will be paid out $300 if the actual outcome matches her wager. Once a play is completed and the result of the play is compared to all current wagers, the account balance of each user who wagered on the play is updated based on the result of the play, the user's wager and the odds on that wager. The database content is then cleared or archived in a database of prior wagers that is kept for auditing purposes.

FIG. 114 provides an illustration that displays the path wagering module 11222. The process begins with the user logging into the wagering app 11228 on a mobile device 11226. Depending upon the embodiment, the user may, at this step, select the game they wish to wager on. This could be utilized, for example, when the user is both wagering and watching the live event 11202 on the mobile device 11226. In another embodiment the user could be watching the live event 11202 on a display 11230 that is separate from the mobile device 11226, such as a television. In that embodiment the odds displayed would be based upon the live event 11202 being displayed on the display 11230. That embodiment could rely on the user's mobile device 11226 being paired with the television or a set top box, or internet TV device attached to that television. In both of these embodiments the live event 11202 the user is watching is identified to the wagering network 11208. The odds database 11216 is then queried for all currently available wagers on the identified live event 11202, which, in this example, is an American football game between the Chicago Bears and the Green Bay Packers, at step 11302. The available wagers retrieved from the odds database 11216 are then displayed to the user on either their mobile device 11226 or another display 11230. In this example, on the 67th play of the game, there are a number of different available wagers, including whether the play will be a run or a pass, how many yards the play will go for, if there will be a turnover, etc., but also wagers on the paths of certain players. In one embodiment, the user could select to wager on a pass. The module will then display available path wagers on specific players, such as the wide receiver number 88 running an out route or a post route. Alternatively, all wagers could be displayed on the first screen and allow the user to wager directly on the out route by wide receiver number 88, without having to first select that they wish to wager on a pass play. How this is configured could be based upon wagering network 11208 administrator preferences, user preferences, or constraints of the display 11230 or mobile device 11226, at step 11404. The mobile device 11226 is then polled for the user selection of one of the displayed wagers that they wish to bet upon, at step 11406. The module then determines if the user has selected to make a wager on this play. This continues until the play is started, at step 11408. If the user has not selected a wager, the module polls the odds database 11216 for new available wagers, at step 11410. The module will return to step 11404 to display the new available wagers. If the user has selected a wager, that wager is recorded in the current wager database 11220, at step 11412. Once the wager is recorded, the AI vision module 11224 is prompted to monitor the live event 11202 feed in order to predict the player's, or in other embodiments the ball's, path through the field of play. As the module becomes more confident in the path of the player or ball, the display of the predicted route will change. For example, user Joe Smith wagered $10 that Packer's wide receiver number 88 will run an out route on the current 3rd down and 7 on the Bears 35 yard line, with 5:15 to go in the 3rd quarter, with the Bears leading 10-7. The AI vision module 11224 will monitor the movements of wide receiver number 88 during the play and calculate the probable path he will take. The user's wagered upon path is displayed over the live event 11202 feed and the AI vision module's 11224 predicted route is also overlaid on the live event 11202 feed. Based on the AI vision module's 11224 confidence in the predicted path, or distance from the wagered upon route, the color or gradient of the predicted path display will change. For example, when the offensive players are in the huddle, a large number of potential routes could be run by a wide receiver. The formation the offense takes, positioning and posture of the players, along with any pre-snap movement can be utilized by the AI to recalculate its confidence in the potential routes of the wide receiver. Such as the wide receiver lining up wide would make it unlikely that he would then run a wheel route, which typically starts in the backfield. As players move leading up to the snap, the AI's confidence in the variety of potential outcomes will change. As more movement data is collected the AI's confidence in certain outcomes will increase. In this example the wide receiver's position at the snap made some outcomes less likely. As the play develops more player movement data is available for the AI to utilize in its calculations. The receiver's initial movement off the line, his first step direction and speed, make it less likely that he will run a slant route. As he continues downfield the movement and angle of his hips could be analyzed looking for a tilt of the hips that indicate the receiver is about to pivot to an out route. The lack of that hip tilt would make the AI more confident in the post or go routes over the out route. In one embodiment, the user's wagered upon route is overlaid on the screen, along with some number of other potential routes the receiver might run. The display of the other routes will change as the AI's confidence in each route changes. As the AI collects more data and becomes more confident that the receiver is running the out route, the display of that route will continue to darken while the representation of other routes becomes lighter as the AI's confidence in those routes declines. Once the play is completed the AI vision module 11224 will return to the path wagering module 11222, at step 11414. Once the AI vision module 11224 is complete, the actual result of the play, in this example the out route run by wide receiver number 88, is compared to the user's wager, at step 11416. The user's wallet balance is then updated based on the wager comparison with the actual result. In this example, user Frank Jones's account balance will increase by $25 ($10 wager with +250 odds), while user Joc Smith ($50) and user Susan Robinson ($100) have their account balance decrease by their wager amount, at step 11418. The module then determines if the user has logged out of the wagering app 11228, at step 11420. If the user has not logged out of the wagering app 11228, the module returns to step 11402. If the user has logged out of the wagering app 11228, the program ends, at step 11422.

FIG. 115 provides an illustration of the AI vision module 11224. The process begins with the receiving of a prompt from the path wagering module 11222 that indicates the user has selected a wager on the path of a player or object, such as the ball, or puck, through the field of play during a play or event inside of the live event 11202, at step 11500. In this example three users, Joe Smith, Frank Jones, and Susan Robinson, have all made wagers on the path of a potential pass catcher on the 67th play between the Chicago Bears and the Green Bay Packers. User Joe Smith and user Frank Jones both wagered that the pass would go to wide receiver number 88, with user Joe Smith wagering on an out route as the receiver's path, and user Frank Jones waging on a post route. User Susan Robinson wagered on the pass going to a different player, running back number 23, with that pass catcher running a wheel route. The live event 11202 feed to each user is adjusted to include an overlay of the path they wagered upon, at step 11502. The sensor feed, and, in this embodiment, the video feed, from the live event 11202 is monitored for movement of the player or object that is being wagered upon, at step 11504. In this embodiment, that is both Green Bay wide receiver number 88 and Green Bay running back number 23. The module will then either proceed to step 11508 or return to step 11504 based on the detection of movement or the detection of no movement, at step 11506. If no movement is detected, the module returns to step 11504. If movement of at least one of the players wagered upon is detected, the module compares that movement to video of that player in past plays in the AI video database 11218, at step 11508. At this point, the module relies on one of a number of artificial intelligence based systems for predicting the route of a player or ball through a field of play based on video analysis of the current play compared to a database of previous video. In this example the AI will examine the movements of the potential pass catchers, wide receiver number 88 and running back number 23, and compare those movements to video of the same player in similar plays in the past, in order to predict where they will travel. These movements could be large scale movements, such as the player's physical position on the field as they run, and they could also be small scale movements such as, the tilt of their shoulders, angle of their hips, focus of their gaze, etc., depending upon the specific algorithm of the AI used. The movement detected is processed by the AI to determine if the detected movement indicates a projected path for the player or object, at step 11510. If the path does not indicate a projected path, for example the first move of the player at the snap of the ball does not eliminate enough possible paths for the AI to make a projection with a high confidence, the module returns to step 11504. If the movement detected does indicate a projected path, that path is overlaid on the user's display 11230 or mobile device 11226, at step 11512. Until the play is complete the module will keep cycling back to step 11504 in order to get the most up to date projected path with the highest confidence level until the play is completed. The projected path that is overlaid on the user's display 11230 or mobile device 11226 changes as these cycles are run. If the projected path changes, then the overlaid path changes. If the confidence level of the projection changes, then the color, shade, or gradient of the projected path changes. For example, the module is monitoring wide receiver number 88 and, at the snap, begins running forward away from the line of scrimmage. At this point there are a number of different routes the receiver could possibly run. If this particular receiver was primarily a deep threat, the module may be able to project that the receiver is running a fly pattern or post route and begin to overlay that route on the user's display 11230 or mobile device 11226. If the receiver is more versatile, the module may not be able to make a projection until more data is collected. Once the module has a projected path, and it is overlaid on the display 11230, the presentation of that path will change based on the confidence level of the AI in the projection. If the receiver runs forward, and the AI is equally confident in a post route, fly pattern or out route, the AI can eliminate the slant route from its list of potential paths. With three equal options, it could either display none of these routes as predictions, or, in other embodiments, it could display all three. As the receiver progresses down field, the AI becomes more confident in the out route as its projection. The other two routes fall off the display overlay, and the out pattern begins to get bolder on the display 11230, or changes color to indicate the AI in gaining confidence in its prediction. This continues until the play is complete, at step 11514. Once the play is complete the AI vision module 11224 sends a prompt, at step 11516 to the path wagering module 11222.

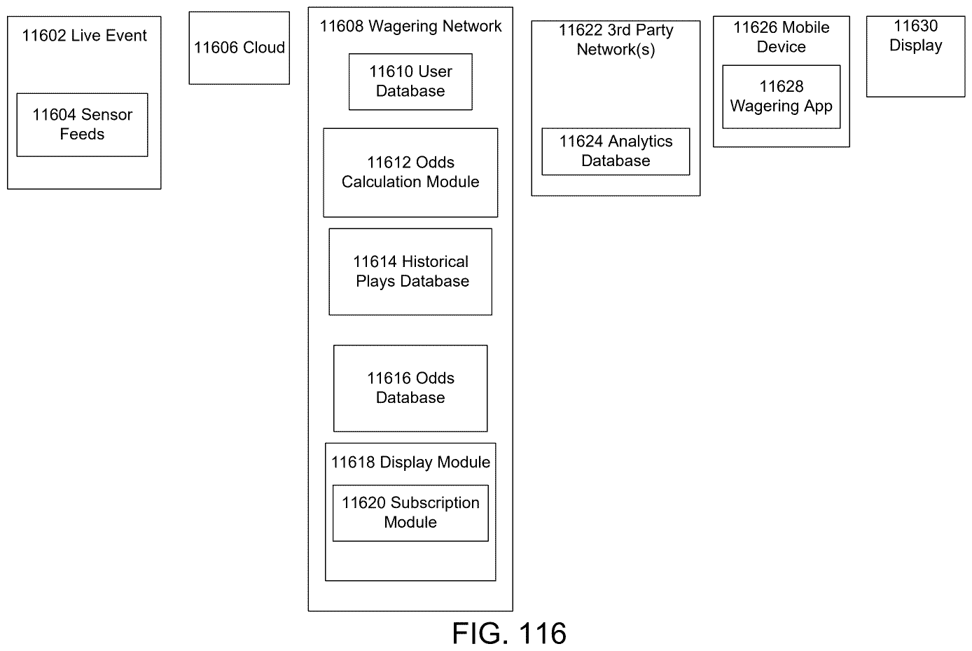

FIG. 116 illustrates a system for a third party analytics integration into a wagering platform, according to an embodiment.

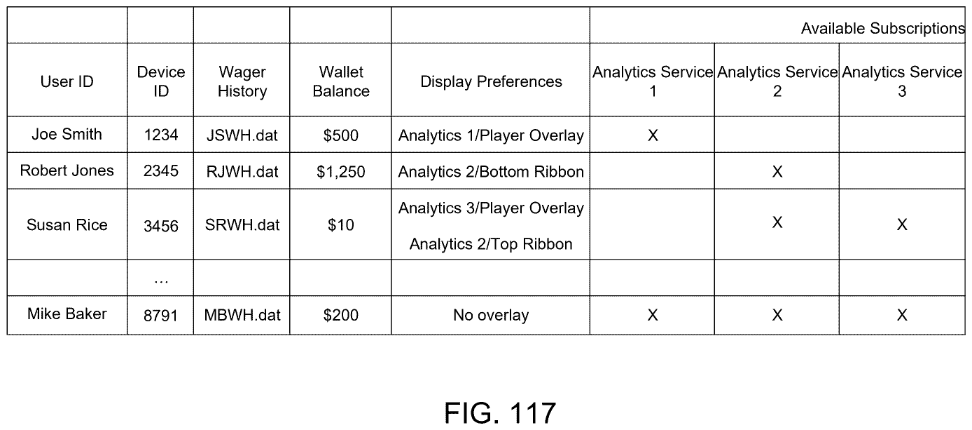

FIG. 117 illustrates a user database, according to an embodiment.

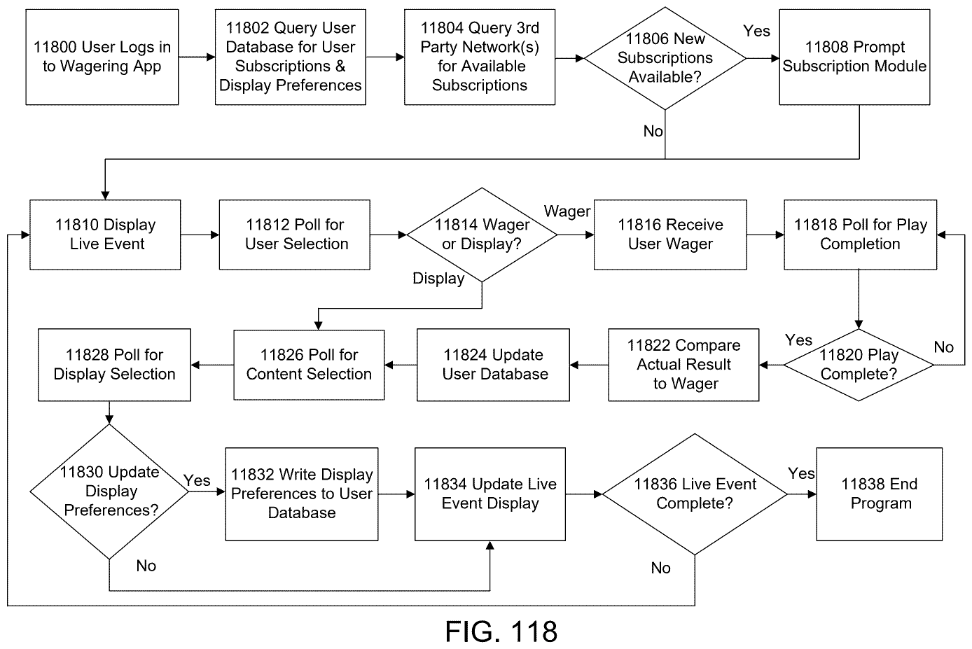

FIG. 118 illustrates a display module, according to an embodiment.

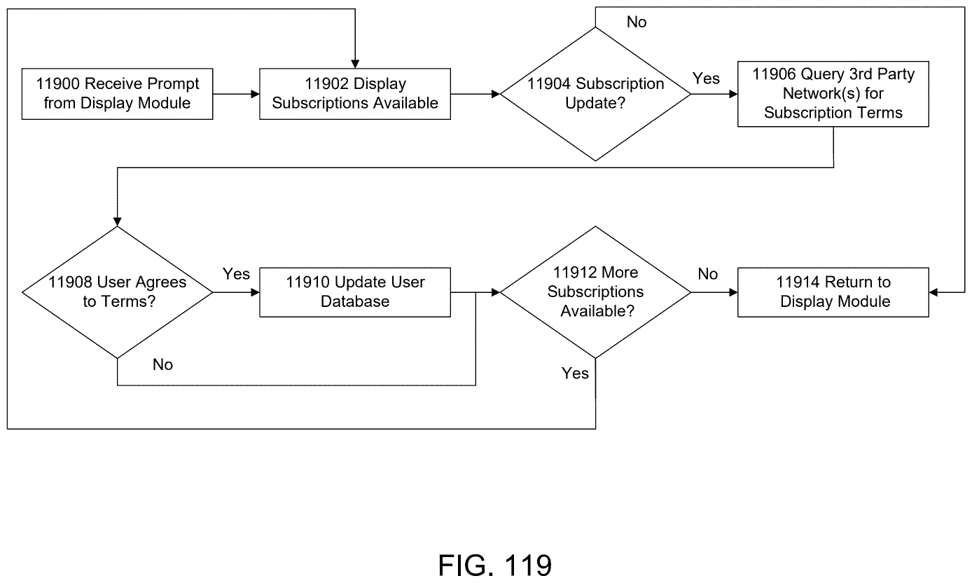

FIG. 119 illustrates a subscription module, according to an embodiment.

FIG. 116 is a system for a third party analytics integration into a wagering platform. The system may include a live event 11602, for example a sporting event such as a football game, basketball game, baseball game, hockey game, tennis match, golf tournament, eSports or digital game, etc. The live event 11602 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 11602, such as the score of American football or the run line in baseball, or a series of action in the live event 11602. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live events in the future. Sportsbooks need to offer payment processing services in order to cash out customers. This can be done at kiosks at the live event 11602 or at another location.

Further, embodiments may include a plurality of sensors 11604 that may be used such as motion sensors, temperature sensors, humidity sensors, cameras such as an RGB-D Camera which is a digital camera capture color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball. In this embodiment only the video feed is used, but in other embodiments additional sensor data can be used to augment the accuracy of the probabilistic engine.

Further, embodiments may include a cloud 11606 or communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable resources and higher-level services that can be rapidly provisioned with minimal management effort, often over the Internet and relies on sharing of resources to achieve coherence and economics of scale, like a public utility, while third-party clouds enable organizations to focus on their core businesses instead of expending resources on computer infrastructure and maintenance. The cloud 11606 may be communicatively coupled to wagering network 11608 which may perform real time analysis on the type of play and the result of the play. The cloud 11606 may also be synchronized with game situational data, such as the time of the game, the score, location on the field, weather conditions, and the like which may affect the choice of play utilized. For example, in other exemplary embodiments, the cloud 11606 may not receive data gathered from sensors and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various exemplary embodiments herein.

Further, embodiments may include a wagering network 11608 which may perform real time analysis on the type of play and the result of a play or action. The wagering network 11608 (or cloud 11606) may also be synchronized with game situational data, such as the time of the game, the score, location on the field, weather conditions, and the like which may affect the choice of play utilized. For example, in other exemplary embodiments, wagering network 11608 may not receive data gathered from sensors and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various exemplary embodiments herein. The wagering network 11608 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user.

Further, embodiments may include a user database 11610 which contains data relevant to all users of the wagering network 11608, which may include, a user ID of the user, a device identifier, a paired device identifier, wagering history, wallet information for the user, the user's selected display settings, and the subscriptions to third party network(s) 11622 the user has subscribed to.

Further, embodiments may include an odds calculation module 11612 which utilizes historical play data, as well as the third party network's 11622 analytics, to calculate odds for in-play wagers. Further, it may be understood that any third party analytics or analytics data can include both statistics and calculated or processed analytics data. Thus, in different embodiments, one or both of statistical information from the third party and analytics from the third party may be utilized.

Further, embodiments may include a historical plays database 11614, that contains play data for the type of sport being played in live event 11602. For example, in American football, for optimal odds calculation, the historical play data should include meta data about the historical plays, such as time, location, weather, previous plays, opponent, physiological data, etc.

Further, embodiments may include an odds database 11616 that contains the odds calculated by the odds calculation module 11612, and is used for reference by the path wagering module 11622 to display the odds on either the user's mobile device 11626 or a secondary display 11630, and to take bets from the user through the mobile device wagering app 11628.

Further, embodiments may include a display module 11618 that coordinates what is shown on the mobile device 11626 through the wagering app 11628. The live event 11602 and available bettors are displayed on the mobile device 11626 according to the user's preferences which are stored in the user database 11610. When a user begins to watch a live event 11602 through the wagering app 11628, the user can access third party network analytics. If the user elects to or has already subscribed to at least one third party network the third party network(s) 11622 are polled for available analytics subscriptions, the available subscriptions are compared to the user's subscriptions in the user database 11610. The mobile device 11626 is polled for user to select either to adjust the display or to place a wager. When the user selects a display adjustment, the analytics data types available from the third party network(s) 11622 that the user has subscribed to are made available, such as various statistics, analyzed data, and the like. The user selects the data type(s) they wish to overlay on the live event 11602 on the display 11630. The user can continue to adjust what analytics are overlaid until the live event 11602 ends, or they elect to place a wager. When a wager is placed the live event 11602 is monitored for the end of the play, the results of the play are then compared to the wager, and the user's account balance/wallet information is adjusted based on the wager result is recorded in the user database 11612. The user can continue to adjust the analytics display and place wagers from play to play through the display module 11618.

Further, embodiments may include a subscription module 11620 that allows the user to view analytics available from third party network(s) 11622 to be integrated with their wagering display. The user will then be able to subscribe to the third party network(s) 11622 that deliver the most value to their wagering experience.

Further, embodiments may include at least one third party network 11622 that provides analytics about the live event 11602 being wagered upon. For example, SportsRadar provides an API into its database of statistics and analytics for the NFL, NBA, NHL, MLB®, ESL and NASCAR. They compile live wagering odds services in addition to the historical play data from that sport. Companies such as Stats Perform, as utilizing artificial intelligence to analyze ball and player movement data to make in game predictions. These types of third party data sources will be utilized in the calculation of odds. In some embodiments the odds calculation module 11612 is outsourced entirely to a third party network 11622 that delivers odds making services, such as SportsRadar or Stats Perform. Users can subscribe to varying levels of access to statistics and analytics data through the third party network(s).

Further, embodiments may utilize at least one analytics database 11624 associated with at least one third party network 11622. Each third party network 11622 connected to the wagering network 11608 will have at least one analytics database 11624. It may be understood that any analytics database 11624 could include any of a variety of data or information, including various statistics, data types, analytics derived from different methodologies, data types, etc. In this example there is just one third party network that stores both their analytics as well as the data that is derived from in one database. However, each third party network 11622 could have a number of different databases for different sports, data types, analytics methods, statistics, etc.

Further, embodiments may include a mobile device 11626, such as a computing device, laptop, smartphone, tablet, computer, smart speaker, or I/O devices. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allow for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also have storage and/or an installation medium for the computing device. In still other embodiments, the computing device may have USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the user device could be an optional component and would be utilized in a situation in which the paired wearable device is utilizing the user device as additional memory or computing power or connection to the internet.

Further, embodiments may include a wagering app 11628, which is a program that enables the user to place bets on individual plays in the live event 11602, and display the audio and video from the live event 11602, along with the available wagers, and statistical and analytical overlays on either the user's mobile device 11626 or their display 1630. The wagering app 11628 allows the user to interact with the wagering network 11608 in order to place bets and allow for the payment/receipt funds based on wager outcomes.

Further, embodiments may include a display 11630, such as a television, smartphone, tablet, gaming console, etc., on which the live event 11602, along with the available wagers, and path overlays can be displayed on instead of, or in addition to being displayed on the mobile device 11626.

FIG. 117 illustrates the user database 11610. The database contains information about all of the users of the wagering network 11608. This information includes, but is not limited to, a user identification, which is the user's name in this example but could also be any other kind of alphanumeric identification. A device identification, for the mobile device 11626 on which the wagering app 11628 is installed. The user's wager history, which is a data file in this example. The user's current wallet/account balance, in this example the balance is in US dollars, but other currencies or non-monetary prizes such as points could be used. The user's display preferences, such as a particular analytics dataset, or statistic inside of that dataset, and how it is displayed in relation to the live event 11602, such as the player's heartrate being overlaid above the player's head, or their top sprint speed in a ribbon along the bottom of the display 11630. The third party network(s) 11622, and which analytics database(s) 11624 the user is subscribed to.

FIG. 118 illustrates the display module 11618. The module begins with the user logging into the wagering app 11628 on their mobile device 11626, at step 11800. The user database 11610 is then queried, at step 11802, for which third party network(s) 11622 and/or analytics database(s) 11624 the user has already subscribed to. The third party network(s) are then queried, at step 11804, for available analytics database(s) 11624 that are available to be subscribed to. It is then determined, at step 11806 if there are any analytics database(s) 11624 that the user has not yet subscribed to. If there are no analytics database(s) 11624 that the user has not yet subscribed to, the module proceeds to step 11810. In this example the user Joe Smith is not yet subscribed to an analytics database(s) 11624. If there is at least one analytics database 11624 available to subscribe to that the user is not already subscribed to, the subscription module 11620 is prompted, at step 11808. The live event 11602 is then displayed, at step 11810, on either the user's mobile device 11626 or the display 11630. In this embodiment the user Joe Smith is controlling the display 11630, which is the user's television, with their mobile device 11626, and is watching the live event 11602 which is an American football game between the Green Bay Packers and the Chicago Bears at Soldier Field in Chicago. The wagering app 11628 is then polled, at step 11812 for a user selection of either making a wager or adjusting the display of at least one of the analytics database(s) 11624 they have subscribed to. If the user elects, at step 11814 to make an adjustment to what live event is displayed, what analytics are displayed, or how they are displayed, the module proceeds to step 11826. In this example, the user Joe Smith elects to display the information in the analytics database 11624 that is relevant to the players currently on the field. If the user elects, at step 11814 to place a wager, the module proceeds to step 11816. In this example the user Joe Smith is wagering that Green Bay quarterback number 12 will throw a completed pass for between 7 and 10 yards on the next play, which is a 3rd down with 5 yards to go for a first down on the Chicago 35 yard line with 3:00 minutes to go in the 3rd quarter, with the Bears leading 20-16. The path taken is based on the selection, at step 11814, by the user to place a wager or adjust the display of analytics. If the user elects to make a wager, in this example the wager is $100 wagered at +250 odds that Green Bay quarterback number 12 will complete a pass on the next play for between 7 and 10 yards, that wager is received, at step 11816 by the module. The live event 11602 is monitored, at step 11818, for the completion of the play wagered upon by the user. The module will continue to return to step 11818 until it determines, at step 11820, that the play is complete. For example, by detecting the whistle blown to signify the end of a play in an American football game. The actual result of the play, in this example a pass completed by Green Bay quarterback number 12 for 8 yards, is compared, at step 11822, to the wagered upon result. In this example the user Joe Smith won their wager of $100 at +250 odds, so his account balance of $500 will change to you $750, after which the user database 11610 is updated, at step 11824, to reflect the change in the user's account balance based upon the result of the wager. Once a wager result's impact on a user's account has been recorded, at step 11824, in the user database 11610, or if the user elected to make a display selection at step 11814, the module polls for a content selection, at step 11826. A content selection can be either changing the live event 11602 being displayed, which analytics database 11624 content they wish to display, or how they want that analytics content to be displayed. For example, the user Joe Smith subscribed to Analytics Service 1, which delivers live streams of player physiological data, such as heart and respiration rate, that is captured through a combination of optical sensors and player worn sensors. After selecting this data at step 11826, the user must make a display selection, at step 11828. In this example the user Joe Smith elects to have the heart rate of each player overlaid on that player's representation. Once the user makes this selection, they module prompts the user, at step 11830, to make this their default display preference. If the user elects, at step 11830 to not make their current display preference their default display preference, the module proceeds to step 11834. If the user elects to make the current display preferences their default display preferences, the new user preferences are written to the user database 11610, at step 11832. The live event 11602 is then displayed, at step 11834, on either the user's mobile device 11626 or the display 11630. In this embodiment the user Joe Smith is controlling the display 11630, which is the user's television, with their mobile device 11626, along with any analytics data that the user has elected to overlay onto the live event 11602 or add as a ribbon along one edge of the display 11630. If the live event 11602 is not completed, the module returns to step 11810. The module determines, at step 11836, if the live event 11602 is complete, or if the user wants to display a different live event 11602. If the live event 11602 is complete, or the user logs out of the wagering app 11628, the program ends, at step 11838.

FIG. 119 illustrates the subscription module 11620. The subscription module 11620 begins with receiving a prompt, at step 11900 from the display module 11618 indicating that there is at least one analytics database 11624 on at least one third party network 11622 that the user has not subscribed to. The analytics database(s) 11624 that are available to be subscribed to are displayed, at step 11902, on the user's mobile device 11626 or the display 11630. The module then polls, at step 11904, the user device 11626 for the user selection to update or not to update their analytics subscriptions. If the user does not want to update their analytics subscriptions, the module proceeds to step 11914. If the user elects, at step 11904, to make a subscription change the third party network 11622 that has the analytics database(s) 11624 that the user has elected to subscribe to, is queried, at step 11906, for the subscription terms for that analytics database 11624. In this example user Joe Smith is electing to subscribe to analytics service 1. The user then decides, at step 11908, if they wish to agree to the subscription terms, such as $25 per month, or $5 per game, or $10 per GB of analytics data, etc., for the available analytics database(s) 11624. If the user does not agree to the subscription terms, the module proceeds to step 11912. If the user does want to subscribe to the analytics database 11624 and agrees, at step 11908 to the subscription terms, the subscription data in the user database 11610 is updated, at step 11910 to include the user's new subscription. While this example only demonstrates the addition of new subscriptions, the module could also be used to remove or change existing subscriptions. The module determines, at step 11912, if there are subscriptions available that have not yet been offered to the user. If more subscriptions are available, the module returns to step 11902. If there are no more subscriptions available, the module returns to the display module 11618, at step 11914.

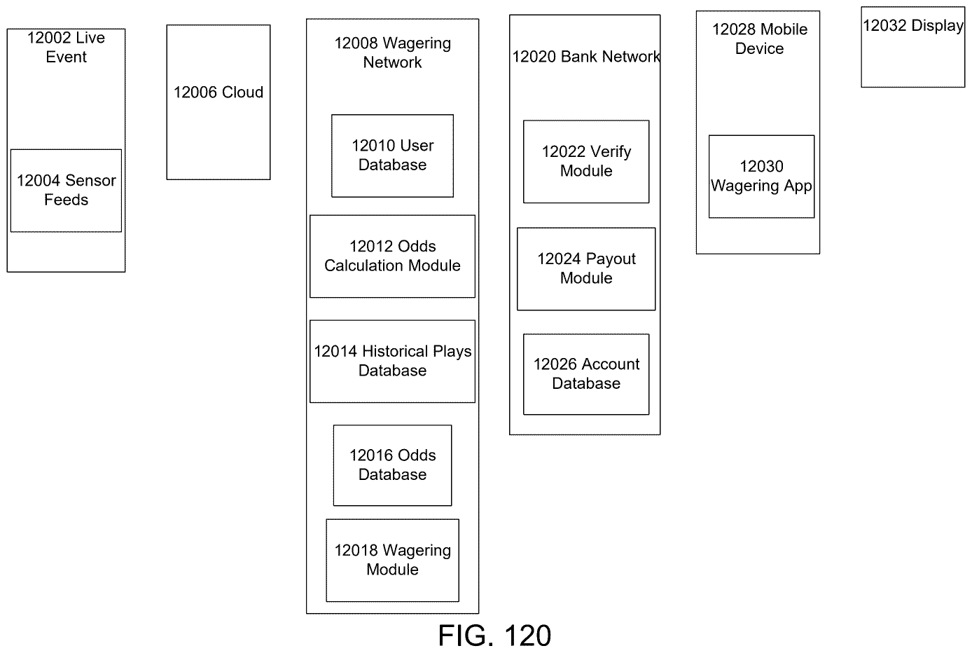

FIG. 120 illustrates a system for 3rd Party Analytics Integration into a wagering platform, according to an embodiment.

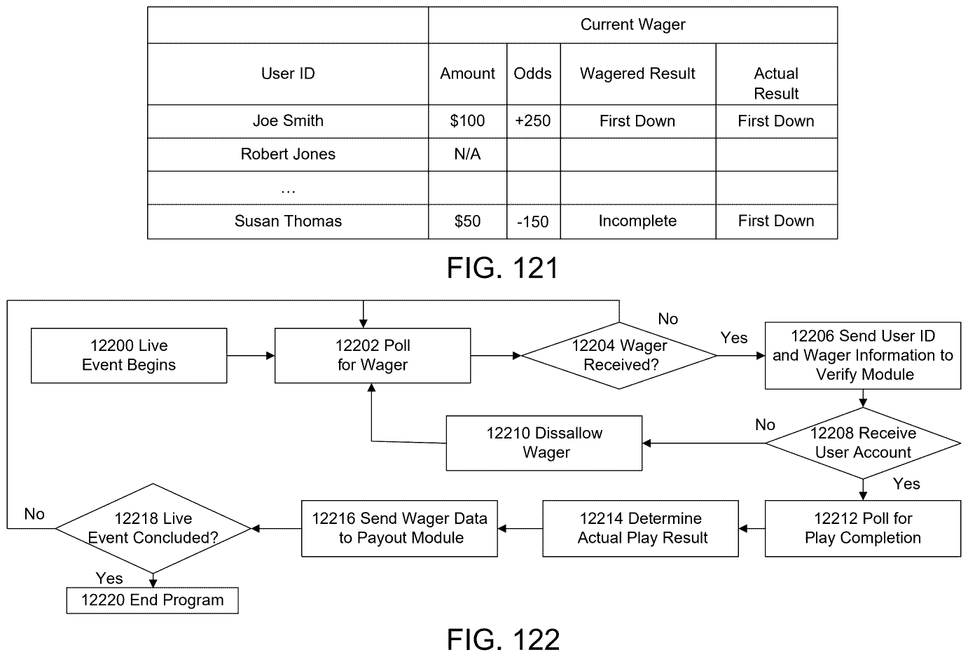

FIG. 121 illustrates a user database, according to an embodiment.

FIG. 122 illustrates a wagering module, according to an embodiment.

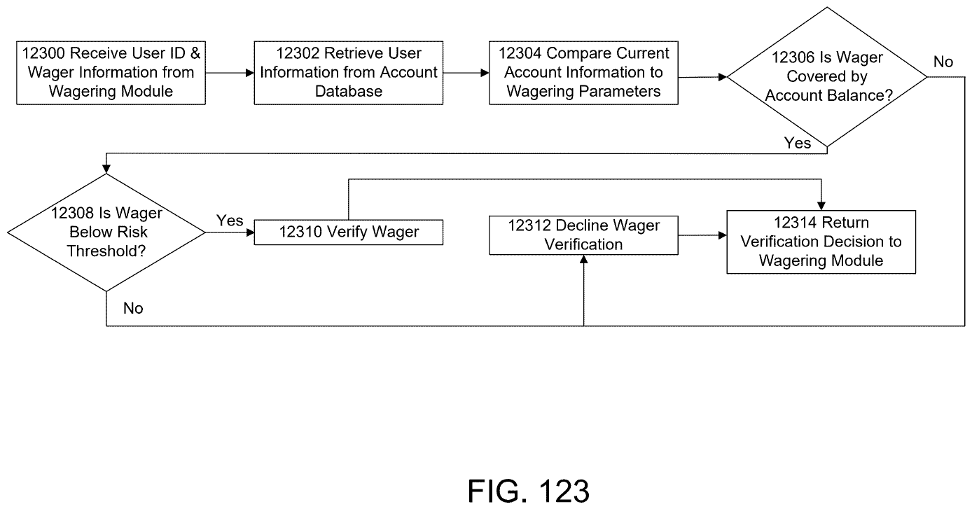

FIG. 123 illustrates a verify module, according to an embodiment.

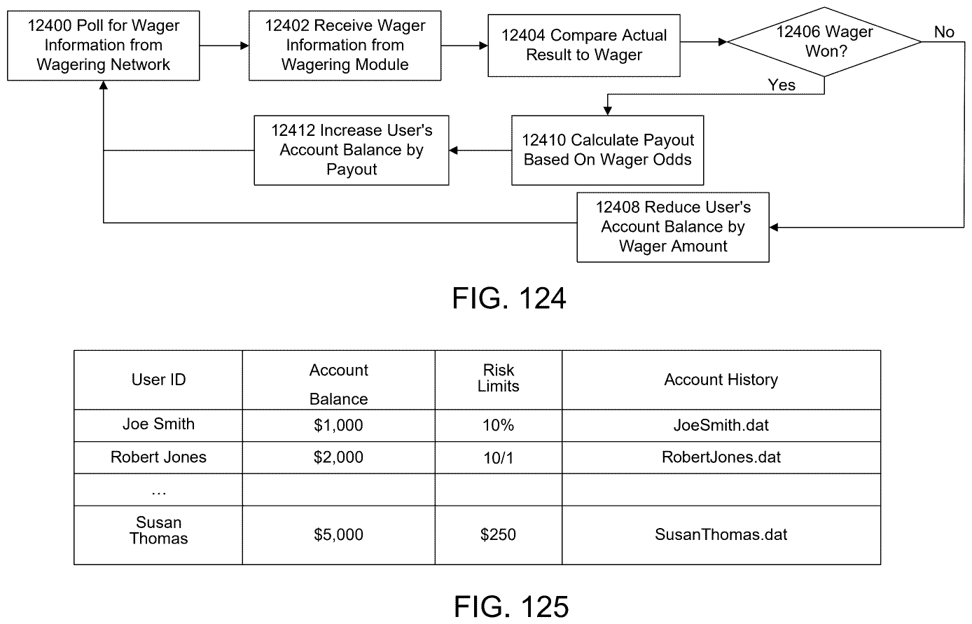

FIG. 124 illustrates a payout module, according to an embodiment.

FIG. 125 illustrates an account database, according to an embodiment.

FIG. 120 is a system for a 3rd Party Analytics Integration into a wagering platform. This system may include a live event 12002, for example a sporting event such as a football game, basketball game, baseball game, hockey game, tennis match, golf tournament, eSports or digital game, etc. The live event 12002 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 12002, such as the score of American football or the run line in baseball, or a series of action in the live event 12002. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live events in the future. Sportsbooks need to offer payment processing services in order to cash out customers. This can be done at kiosks at the live event 12002 or at another location.

Further, embodiments may include a plurality of sensors 12004 that may be used such as motion sensors, temperature sensors, humidity sensors, cameras such as an RGB-D Camera which is a digital camera capture color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball. In this embodiment only the video feed is used, but in other embodiments additional sensor data can be used to augment the accuracy of the probabilistic engine.

Further, embodiments may include a cloud 12006 or communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable resources and higher-level services that can be rapidly provisioned with minimal management effort, often over the Internet and relies on sharing of resources to achieve coherence and economies of scale, like a public utility, while third-party clouds enable organizations to focus on their core businesses instead of expending resources on computer infrastructure and maintenance. The cloud 12006 may be communicatively coupled to wagering network 12008 which may perform real time analysis on the type of play and the result of the play. The cloud 12006 may also be synchronized with game situational data, such as the time of the game, the score, location on the field, weather conditions, and the like which may affect the choice of play utilized. For example, in other exemplary embodiments, the cloud 12006 may not receive data gathered from sensors and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various exemplary embodiments herein.

Further, embodiments may include a wagering network 12008 which may perform real time analysis on the type of play and the result of a play or action. The wagering network 12008 may also be synchronized with game situational data, such as the time of the game, the score, location on the field, weather conditions, and the like which may affect the choice of play utilized. For example, in other exemplary embodiments, wagering network 12008 may not receive data gathered from sensors and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various exemplary embodiments herein. The wagering network 12008 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may include a user database 12010 which contains data relevant to all users of the wagering network 12008, which may include, a user ID of the user, their current wager, the odds on that wager, the wagered upon results and the actual result. The user database 12010 may also include a device identifier for their mobile device 12028, a paired device identifier, wagering history on the user, etc.

Further, embodiments may include an odds calculation module 12012 which utilizes historical play data, as well as a third party network's analytics, to calculate odds for in-play wagers.

Further, embodiments may include a historical plays database 12014, that contains play data for the type of sport being played in live event 12002. For example, in American football for optimal odds calculation, the historical play data should include meta data about the historical plays, such as time, location, weather, previous plays, opponent, physiological data, etc.

Further, embodiments may include an odds database 12016 that contains the odds calculated by the odds calculation module 12012, and is used for reference by the path wagering module 12018 to display the odds on either the user's mobile device 12028 or a secondary display 12032, and to take bets from the user through the mobile device wagering app 12030.

Further, embodiments may include a wagering module 12018 that allows the user to place wagers on individual plays inside of the live event 12002 through the wagering app 12030. The wagering module 12018 displays the available wagers from the odds database 12016 on either the mobile device 12028 or a secondary display 12032. The wagering module 12018 will first verify that the user has a valid account with the bank network 12020, and sufficient funds to place a given wager. Once a wager is placed, the live event 12002 is monitored for the end of the play, in this example the whistle of the referee in an America football game. The actual play result is compared to the wager. The play result, wager, wager amount, and odds are then sent to the payout module 12024 which will settle the wager. The wagering app 12030 is then monitored for more wagers until the user logs off or the live event 12002 is complete.

Further, embodiments may include at least one bank network 12020 that hosts the users' account information kept in the account database 12026, verifies for the wagering module 12018 that the user has sufficient funds in their account to use the wagering app, or place an individual wager with the verify module 12022, and settles the users' account based on the result of wagers placed through the wagering module 12018 with the payout module 12024. It may be understood that the bank network 12020 may be directly integrated with the wagering platform or may be part of an external, or third party, bank network 12020, or may be banking, account, or monetary information otherwise integrated into the wagering platform. Thus, in the embodiments, interactions with or actions taken with regard to data in the bank network 12020 may be performed within the wagering platform or based on communications with a third party bank network 12020. Further, it may be understood that the wagering platform may include an account or other database containing available money, points, credits, or the like that can be wagered. This account or other database may be communicatively coupled to an outside or third party bank account so as to provide for transfers of money, points, credits, or the like.

Further, embodiments may include a verify module 12022 which handles queries from the wagering module 12018 about the user's account status to ensure that they have the funds in their account to place wagers through the wagering app 12030.

Further, embodiments may include a payout module 12024 which is notified when the user places a wager on a completed play and delivers the amount of the wager, odds of the wager and the result of the play relative to the wager, such as a $100 wager that the next play will be a pass in American football, at +250 odds, with the result of the play being a pass. The payout module 120124 will then retrieve the user's account information from the account database 12026 and adjust the user's account balance, either down by the wager amount when the wagered upon result does not match the actual result, or as is the case in this example, the user keeps their original wager amount of $100, and gets an additional $250 as a result of the +250 odds on the wager. The user's account balance goes from $1000 before the wager to $1250 after the wager. Further, it may be understood that if an account balance is adjusted, that information is only known or reflected on the bank network 12020. In other words, any user account information, such as monetary information, may be shielded from the wagering platform, such that the wagering platform cannot access or otherwise determine, for example, an amount of money a user has in an account on the bank network 12020 or any other transactions that have taken place for a user on the bank network 12020. Thus, in an embodiment, both the wagering platform and bank network 12020 are secure. Further, in embodiments where the bank network 12020 is housed on the wagering platform, any wagering game on the wagering network 12008 may only be provided information on funds related to a specific wager or to a risk limit, risk limitation, or other threshold, as described below, but may not be provided with a total amount of available funds (or points, credits, etc.) in an account on bank network 12020.

Further, embodiments may include an account database 12026 that houses the account information of the users of the bank network 12020. This will include at least a user ID, account number, and current balance. It could also include additional user information, such as a device identifier, biometrics, passwords, etc.

Further, embodiments may include an embodiment includes a mobile device 12028 such as a computing device, laptop, smartphone, tablet, computer, smart speaker, or I/O devices. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allow for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may have USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In this invention the user device could be an optional component and would be utilized in a situation in which the paired wearable device is utilizing the user device as additional memory or computing power or connection to the internet.

Further, embodiments may include a wagering app 12030, which is a program that enables the user to place bets on individual plays in the live event 12002, and display the audio and video from the live event 12002, along with the available wagers, and statistical and analytical overlays on either the user's mobile device 12028 or their display 12032. The wagering app 12030 allows the user to interact with the wagering network 12008 in order to place bets and deliver payment/receive funds based on wager outcomes.

Further, embodiments may include a display 12032, such as a television, smartphone, tablet, gaming console, etc., on which the live event 12002, along with the available wagers, and path overlays can be displayed on instead of, or in addition to being displayed on the mobile device 12028.

FIG. 121 illustrates the user database 12010. The user database 12010 contains information related to all users of the wagering app 12032. This may include a used identification, in this example the user's name, along with data about their current wager, including the wager amount, wagered upon amount and the odds of the wager. The database could also contain additional information about the user, such as a device ID, their wagering history, geolocation, favorite teams, players, sports, etc.

FIG. 122 illustrates the wagering module 12018. The process begins with the start of the live event 12002, at step 12200. The wagering module 12018 then polls, at step 12202 for wagers made by users of the wagering app 12030 on the live event 12002. The wagering module 12018 returns to step 12202 if no wager is received, at step 12204. In this example, the user Joe Smith is placing a $100 wager at +250 odds that the next play between the Green Bay Packers and the Chicago Bears will be a completed pass by the Green Bay Packers, and user Susan Thomas is wagering $200 at +150 odds that the same play will be a run. The user ID, wager amount and odds of the wager are sent, at step 12206 to the verify module 12022 on the bank network 12020. A verification or declination of the wager is then received, at step 12208 by the wagering module 12018 from the verify module 12022. If the wager was declined, the wager is disallowed, at step 12210 and the wagering module 12018 returns to step 12202. If the wager is verified, at step 12208 the sensor feeds 12004 are polled, at step 12212 for the completion of the wagered upon play. When it is determined that the play has been completed, such as by the referee's whistle in an American football game, the actual result of the play is determined, at step 12214. The wager data, including the amount of the wager, wagered upon result, odds of the wager and the actual play result, are sent, at step 12216 to the payout module 12024. The wagering module 12018 then determines, at step 12218 if the live event 12002 has concluded. If the live event 12002 has not concluded, the wagering module 12018 returns to step 12202. If the live event 12002 has concluded the wagering module 12018 ends, at step 12220.

FIG. 123 illustrates the verify module 12022. The process begins with the verify module 12022 receiving a user ID and information related to a wager made by that user from the wagering module 12018, at step 12300. The information related to that user is then retrieved from the account database 12026, at step 12302. The user's current account information, including account balance and risk thresholds, is compared to the wager information, including amount of the wager and the odds, at step 12304. The first verification step is for the verify module 12022 to determine that the user's account balance is greater than the wager amount, at step 12306. If the wager amount exceeds the account balance of the user, the verify module 12022 proceeds to decline the wager at step 12312. If the wager amount is below the account balance, the wager amount is compared to the user's risk limits, at step 12308. In this example, the user Joc Smith's wager of $100 is below both his account balance of $1000 and his risk limit of 10% of his account balance, which is $100. This wager is approved, at step 12310. If the wager amount exceeds the risk limit of the user, the wager is declined, at step 12312. The verification or declination of the wager is then returned to the wagering module 12018, at step 12314. In other examples, it may be appreciated that an account balance may act as the risk limit or risk limitation, or otherwise act as a threshold which could be utilized by the verify module 12022 to accept or decline a wager.

FIG. 124 illustrates the payout module 12024. The process begins with the payout module 12024 polling, at step 12400 the wagering network 12008 for a wager made through the wagering module 12018. The wagering module 12018 delivers to the payout module 12024 with information related to the wager at step 12402, including at least, the wager amount, the odds of the wager, the wagered upon result of the play, the actual result of the play, and the user who made the wager. The actual result of the play is then compared, at step 12404 to the wagered upon result of the play. For example, the user Joe Smith wagered $100 that the play would be a completed pass, while user Susan Thomas wagered $200 on the play being a run. The actual result of the play was a pass. The payout module 12024 determines, at step 12406 that user Joe Smith won his wager and user Susan Thomas lost her wager. If the user lost their wager their account balance is reduced, at step 12408 by the wager amount. In this example, user Susan Thomas wagered $200, so her account balance would be reduced from $5000 to $4800 in the account database 12026. If the user's wagered upon result matches the actual result of the play, the payout to the user is calculated, at step 12410 based on the wager amount, in this example $100, and the odds, in this example +250, resulting in a payout of $250. The user's account balance in the account database 12026 is then increased, at step 12412 by the payout amount. In this example user Joe Smith's original account balance of $1000 increases to $1250 based on wining a wager of $100 at +250 odds. The payout module 12024 then returns to step 12400 polling for more wager results being sent from the wagering network 12008.

FIG. 125 illustrates the account database 12026. The account database 12026 contains the account information for users of the bank network 12020. This may include, a user identifier, such as an account number, the balance of the user's account(s), the risk limits on their account, and the account's history. The user identification can be a simple one to one relationship of an ID or name, as it is in this example, but could also be done through any of a variety of encrypted methods. Each user's current account balance, in this example is in US dollars. Each user has risk limits associated with their account. These risk limits are set by the user in this example, but could also be imposed by the bank network 12020 based on user history, credit worthiness, account balance, etc. In this example the users have set limits in terms of the maximum amount of money they can wager on a single bet, such as user Susan Thomas's $250 bet limit, in terms of a percentage of their account, such as user Joe Smith's 10% limit which would prevent him from wagering more than $100 on a single bet given his current $1000 account balance, and in terms of odds, such as user Robert Jones's limit of 10 to 1 odds preventing him from wagering on longshots. This example contains the user's account history and related information stored as a data file, but there are numerous ways known in the art for bank account record keeping that could be used in this database.

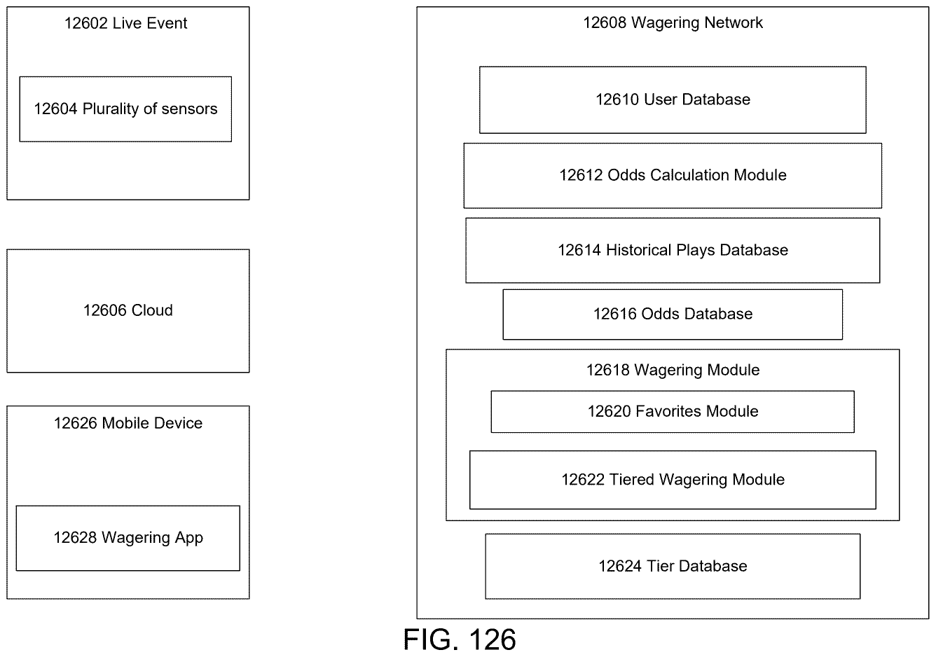

FIG. 126 illustrates a system for a player focused wagering system, according to an embodiment.

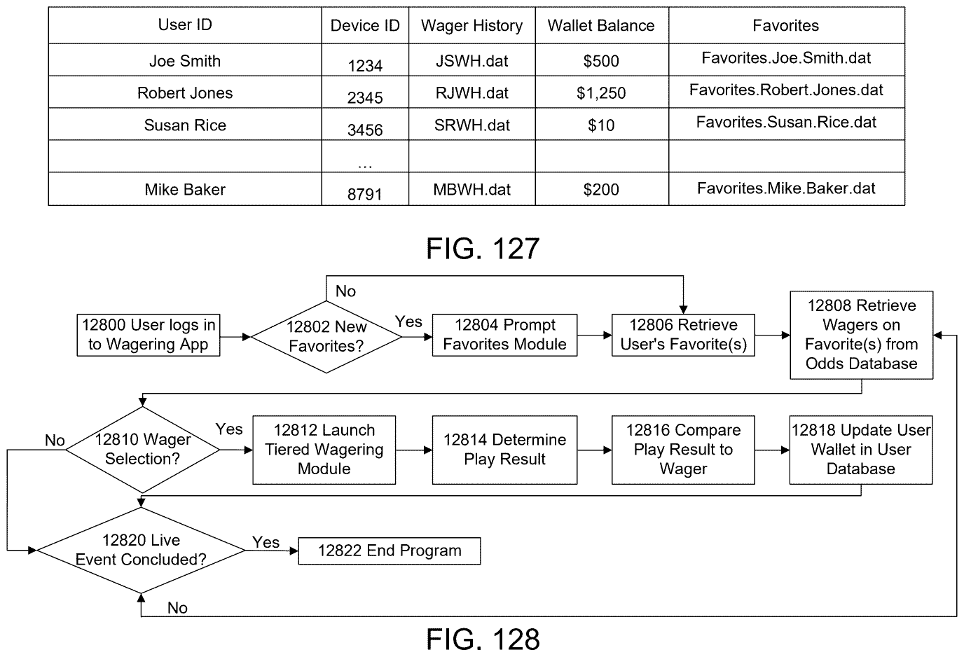

FIG. 127 illustrates a user database, according to an embodiment.

FIG. 128 illustrates a wagering module, according to an embodiment.

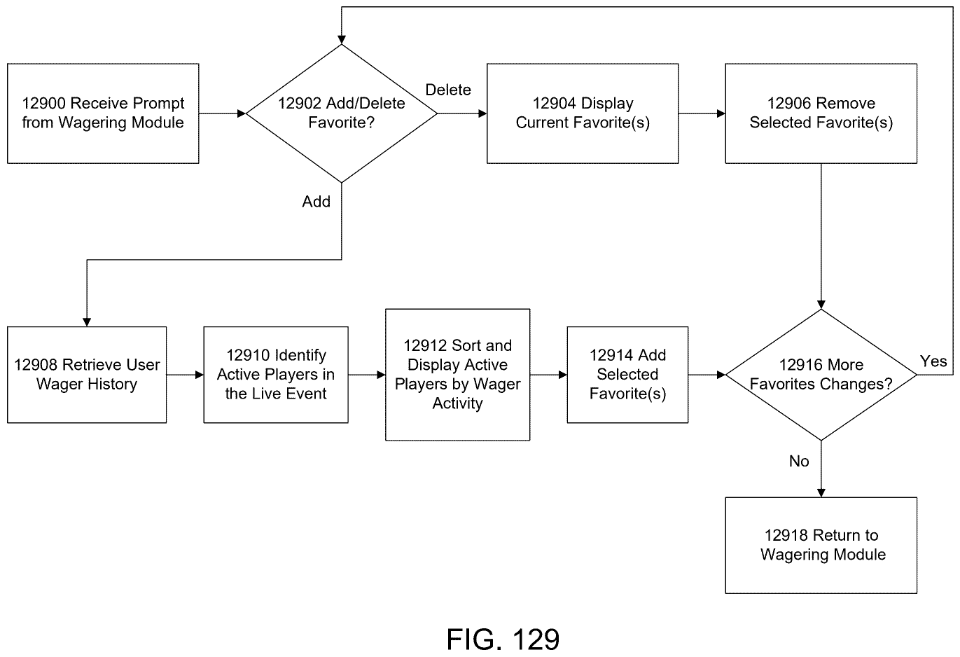

FIG. 129 illustrates a favorites module, according to an embodiment.

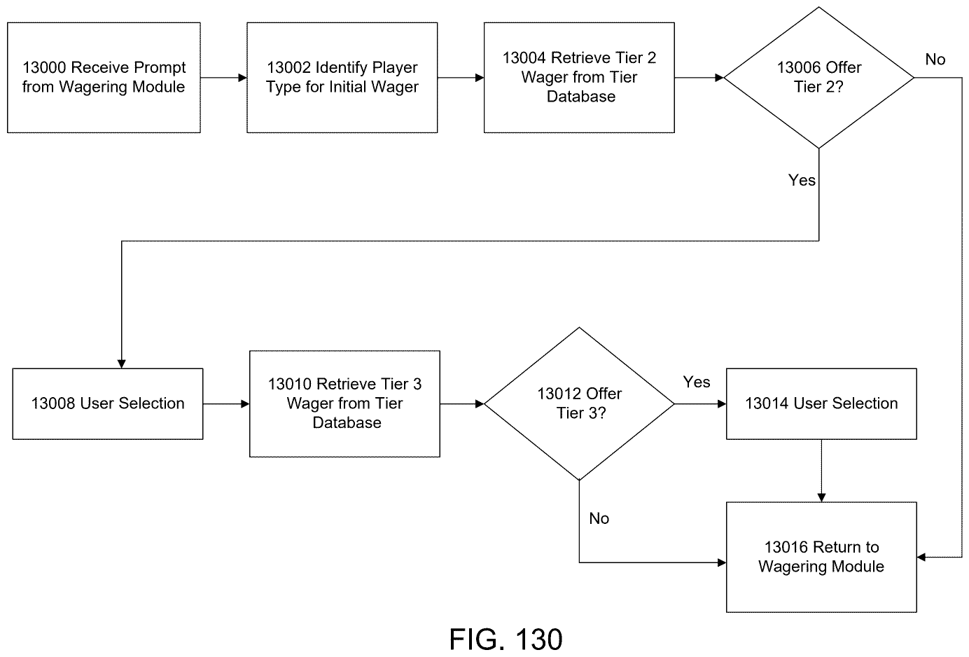

FIG. 130 illustrates a tiered wagering module, according to an embodiment.

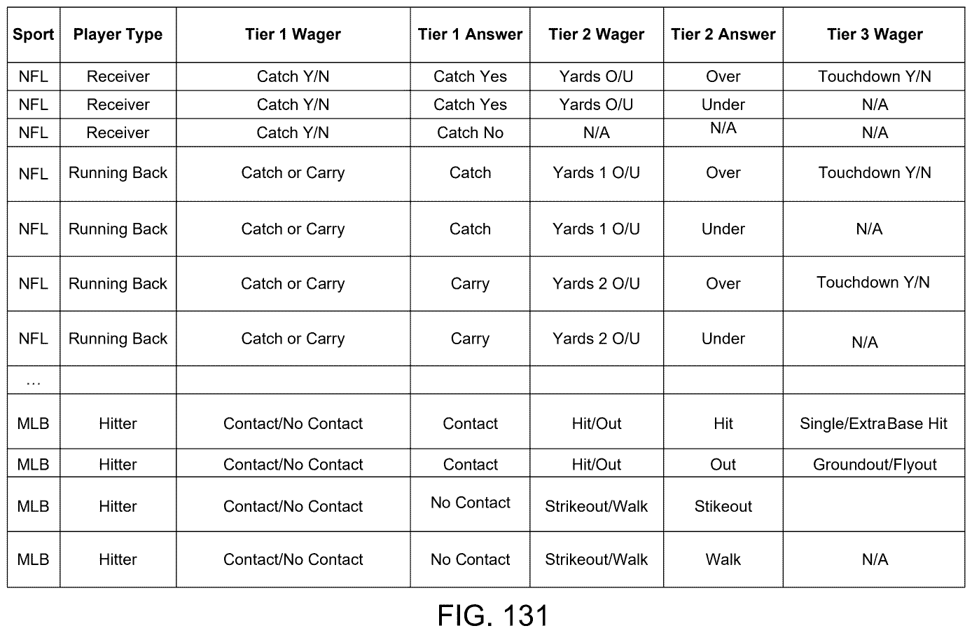

FIG. 131 illustrates a tier database, according to an embodiment.

FIG. 126 is a system for a player focused wagering system. This system may include a live event 12602, for example a sporting event such as a football game, basketball game, baseball game, hockey game, tennis match, golf tournament, eSports or digital game, etc. The live event 12602 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 12602, such as the score of American football or the run line in baseball, or a series of action in the live event 12602. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live event 12602 in the future. Sportsbooks need to offer payment processing services in order to cash out customers. This can be done at kiosks at the live event 12602 or at another location.

Further, embodiments may include a plurality of sensors 12604 that may be used such as motion sensors, temperature sensors, humidity sensors, cameras such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 12606 or communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the Internet and relies on sharing of resources to achieve coherence and economics of scale, like a public utility, while third-party clouds allow organizations to focus on their core businesses instead of expending resources on computer infrastructure and maintenance. The cloud 12606 may be communicatively coupled to wagering network 12608 which may perform real time analysis on the type of play and the result of the play. The cloud 12606 may also be synchronized with game situational data, such as the time of the game, the score, location on the field, weather conditions, and the like which may affect the choice of play utilized. For example, in other exemplary embodiments, the cloud 12606 may not receive data gathered from plurality of sensors 12604 and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various exemplary embodiments herein.

Further, embodiments may include a wagering network 12608 which may perform real time analysis on the type of play and the result of a play or action. The wagering network 12608 (or cloud 12606) may also be synchronized with game situational data, such as the time of the game, the score, location on the field, weather conditions, and the like which may affect the choice of play utilized. For example, in other exemplary embodiments, wagering network 12608 may not receive data gathered from plurality of sensors 12604 and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various exemplary embodiments herein. The wagering network 12608 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may include a user database 12610 which contains data relevant to all users of the system, which may include a user ID of the user, a device identifier for their mobile device 12626, a list of the players indicated as favorites by the user through the favorites module 12620, and could also include wagering history on the user, and other relevant user data.

Further, embodiments may include an odds calculation module 12612 which utilizes historical play data to calculate odds for in-play wagers.

Further, embodiments may include a historical plays database 12614, that contains play data for the type of sport being played in live event 12602. For example, in American football for optimal odds calculation, the historical play data should include meta data about the historical plays, such as time, location, weather, previous plays, opponent, physiological data, etc.

Further, embodiments may include an odds database 12616 that contains the odds calculated by the odds calculation module 12612 to display the odds the user's mobile device 12626 and to take bets from the user through the mobile device wagering app 12628.

Further, embodiments may include a wagering module 12618 that allows the user to place wagers on individual plays inside of the live event 12602 through the wagering app 12628. The wagering module 12618 will allow the user to indicate favorite players and prompt the favorites module 12620 if the user gives that indication. The wagering module 12618 displays the available wagers related to at least one of the user's indicated favorite players from the odds database 12616 on the mobile device 12626. A player indication of a wager on one of the presented wager options will prompt the tiered wagering module 12622 to allow the user to build a question-based parlay. Once a wager is placed, the live event 12602 is monitored for the end of the play, in this example the whistle of the referee in an America football game. The actual play result is compared to the wager. The play result, wager, wager amount, and odds are then used calculate the adjustment to the user's wallet information in the user database 12610. The wagering app 12628 is then monitored for more wagers until the user logs off or the live event 12602 is complete.

Further, embodiments may include a favorites module 12620 that allows users to indicate player(s) they have a greater interest in wagering on favorites module 12620. Further, embodiments may include a tiered wagering module 12622 that allows the user to build their initial wager into a parlay with a serious of additional wager offers, in which the additional wagers offered are based upon the previous wager response as per the rules in the tier database 12624.

Further, embodiments may include a tier database 12624 that contains the rules used by the tiered wagering module 12622 in determining which wager to display for the user based upon the previous wager response.

Further, embodiments may include a mobile device 12626 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allow for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a Fire Wire bus, an Ethernet bus, a Gigabit Ethernet bus, a Fiber Channel bus, or a Thunderbolt bus. In some embodiments the mobile device 12626 could be an optional component and would be utilized in a situation in which a paired wearable device is utilizing the mobile device 12626 as additional memory or computing power or connection to the internet.

Further, embodiments may include a wagering app 12628, which is a program that enables the user to place bets on individual plays in the live event 12602, and display the audio and video from the live event 12602, along with the available wagers on the mobile device 12626. The wagering app 12628 allows the user to interact with the wagering network 12608 in order to place bets and provide payment/receive funds based on wager outcomes.

FIG. 127 illustrates the user database 12610. The database contains information about all of the users of the wagering network 12608. This information includes, but is not limited to, a user identification, which is the user's name in this example but could also be any other kind of alphanumeric identification. A device identification, for the mobile device 12626 on which the wagering app 12628 is installed. The user's wager history, which is a data file in this example. The user's current wallet/account balance, in this example the balance is in US dollars, but the system could use other currencies or non-monetary prizes such as points. The favorite player(s) indicated by each user through the favorites module 12620.

FIG. 128 illustrates the wagering module 12618. The process begins with the user logging into the wagering app 12628, at step 12800. The user can then indicate, at step 12802, that they wish to add or change a player or players on their favorites list. If the user indicates, at step 12802, that they want to add or change to their favorites list, the favorites module 12620 is prompted, at step 12804. The favorites module 12620 is automatically prompted, at step 12804, if the user has not previously used the favorites module 12620. Once the favorites module 12620 has run, or if the user does not elect to make changes to their favorites list at step 12802, the module then retrieves, at step 12806, the user's favorites list from the user database 12610. Wagers available for plays in the live event 12602 are retrieved, at step 12808, from the odds database 12616 and filtered for wagers that are applicable to at least on player on the user's favorites list. For example, user Joe Smith has Atlanta Falcons wide receiver Julio Jones as one of his indicated favorite players. There are wagers available on the next play that are applicable to Julio Jones as well as the running back, the tight end, the second wide receiver and the opposing team's defense. In this example, user Joe Smith would only see the tier 1 wagers available on Julio Jones, which is a yes/no on if he will catch a pass on the next play. The wagering module 12618 then polls, at step 12810 for the user's wager selection. If no wager selection is received at step 12810, the wagering module 12618 proceeds to step 12820 to determine if the live event 12602 is complete. If the user makes a wager selection at step 12810, the tiered wagering module 12622 is prompted, at step 12812. Once the player's wager is completed through the tiered wagering module 12622, the live event 12602 is monitored to determine, at step 12814, the result of the play. The actual result of the play is compared, at step 12816, to the wagered upon result. In this example the user Joe Smith wagered that Julio Jones would catch a pass, that it would be for more than 10 yards and he would not score a touchdown. The actual result of the play was a completed pass to Julio Jones for 14 yards, and no touchdown. In this example, user Joe Smith won each of the three parts of his wager. The user's wallet information in the user database 12610 is then updated, at step 12818, to reflect the result of the wager. In this example, user Joe Smith has a starting balance of $500. His initial wager was $100 (at even money) that Julio Jones would catch a pass on the play. He indicated that the pass would be over 10 yards (at −200) for his tier 2 wager. He indicated that Julio Jones would not score on the play (−400). In this example, user Joe Smith has made three independent $100 wagers, one at even money, one at −200, and one at −400. The first wager would pay out $100 on top of his initial wager, the second $50 and the third $25, bringing his account balance from $500 to $675. While in this embodiment each wager tier is an independent betting event, the wagers could be combined in one of the many ways known in the art, such as a parlay or multiplier. The module then determines, at step 12820, if the live event 12602 was concluded. If the live event 12602 is not concluded, the module returns to step 12808. If the live event 12602 has concluded, or the user has logged off the wagering app 12628, the program ends, at step 12822.

FIG. 129 illustrates the favorites module 12620. The process begins with receiving a prompt, at step 12900 from the wagering module 12618 that the user needs to create a favorites list because they have not yet created one, or they have indicated they want to add to or change their favorites list. The user then indicates, at step 12902, if they wish to add to their favorites list or delete players from their favorites list. If the user indicates, at step 12902, that they wish to add player(s) to the favorites list, the module proceeds to step 12908. If the user indicates, at step 12902, that they wish to delete player(s) from their favorites list, their favorites list is retrieved from the user database 12610 and displayed, at step 12904, on the user's mobile device 12626. The player(s) indicated by the user are removed, at step 12906, from their favorites list in the user database 12610, and the module proceeds to step 12916. If the user indicates, at step 12902, that they wish to add player(s) to the favorites list, the user's wager history is retrieved, at step 12908, from the user database 12610. The players active in the live event 12602 are identified, at step 12910. The active players in the live event 12602 are compared to the user's wager history to identify the active players the user has wagered on in the past, which are then sorted by how often the user has wagered on each player in the past and displayed, at step 12912, on the mobile device 12626 with the most frequently wagered upon players at the top of the list. User selected player(s) from the list are added, at step 12914, to the user's favorites list in the user database 12610. The module then receives, at step 12916, an indication from the user if they need to make additional changes to their favorites list. If more changes are needed, the module returns to step 12902. If no additional changes are indicated by the user at step 12916, the process returns, at step 12918 to the wagering module 12618.

FIG. 130 illustrates the tiered wagering module 12622. The process begins with receiving, at step 13000, a prompt from the wagering module 12618 that the user has indicated a wager selection. In this example user Joe Smith indicated a wager of $100 on Julio Jones catching a pass on the next play of the live event 12602 at even money. The player type of the wagered upon player is identified, at step 13002. In this example the wagered upon player, Julio Jones, is a receiver in an NFL game. The tier 2 wager options for the identified player type are retrieved, at step 13004 from the tier database 12624. The user's initial wager, in this example that Julio Jones will catch a pass, is compared to the conditions for tier 2 wagers in the tier database 12624 to determine, at step 13006 if a tier 2 wager option is displayed on the mobile device 12626. In this example, the tier 2 wager options for a wager that a receiver in an NFL game will catch a pass, is an over/under bet. The distance of the over/under, in this example ten yards, is determined by the odds calculation module 12612 based on information in the historical plays database 12614. If the user Joe Smith had wagered against Julio Jones making a catch, there would be no tier 2 wagered offered and the process would proceed to step 13016. The user's wager selection is received, at step 13008. If the user indicates not taking the tier 2 wager the process proceeds to step 13016. The tier 3 wager options available based on the user's indication on the tier 2 wager is retrieved, at step 13010 from the tier database 12624. The user's tier 2 wager, in this example that Julio Jones will catch a pass for over ten yards, is compared to the conditions for tier 3 wagers in the tier database 12624 to determine, at step 13012 if a tier 3 wager option is displayed on the mobile device 12626. In this example, the tier 3 wager options for a wager that a receiver in an NFL game will catch a pass for over the over/under threshold, is a yes/no wager on a touchdown. If the user Joe Smith had wagered that Julio Jones a catch for under the over/under threshold, there would be no tier 3 wagered offered and the process would proceed to step 13016. The user's wager selection is received, at step 13014. If the user indicates not taking the tier 3 wager the process proceeds to step 13016. When the user's wager selections are complete, the module returns, at step 13016 to the wagering module 12618.

FIG. 131 illustrates the tier database 12624. The database contains the rules used by the tiered wagering module 12622 to determine which wagers to offer a user based on their response to a previously offered wager. In this embodiment the rules are broken up first by sport, such as American football, baseball, basketball, etc., then by player type, such as receiver or running back in football or a hitter or pitcher in baseball, etc. These categories of player then each have tiers of wagers, in this example there are three tiers of wagers. For a hitter in a baseball game the initial wager option could be contact/no contact. If the user indicates no contact on the tier 1 wager, they are presented with walk/strikeout as tier 2 wager options. If the user indicates a walk there is no tier 3 wager, while if they indicate strikeout for the tier 2 wager, they are presented with looking/swinging for the tier 3 wager. While in this example an at-bat is used as the play interval for the wagers offered, wagers in baseball could also be made pitch to pitch, inning to inning, etc. For a running back in football the first tier wager could be the user indicating the player will catch the ball on a passing play or carry the ball on a running play. Each response has an over/under wager associated with it; this is the second tier wager. While this situation has the same wager type, an over/under, in tier 2 the wagers would potentially be for different yardages due to the different play type, run/pass. If the user selects the under for either option, there is no tier 3 option. If the user indicates the over, an option to wager yes/no on the player scoring a touchdown is presented as the tier 3 wager.

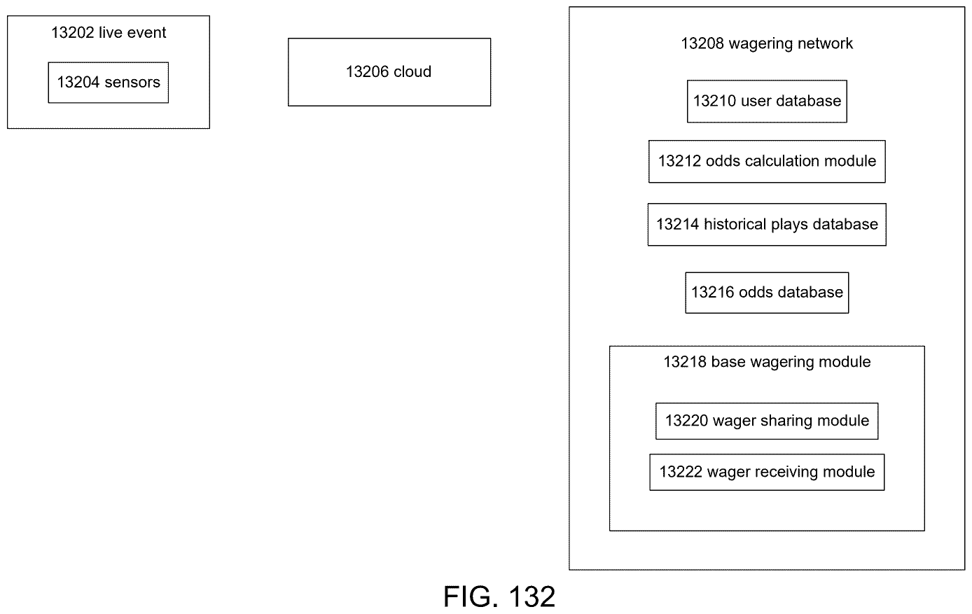

FIG. 132 illustrates a system for a wager sharing and invitation method, according to an embodiment.

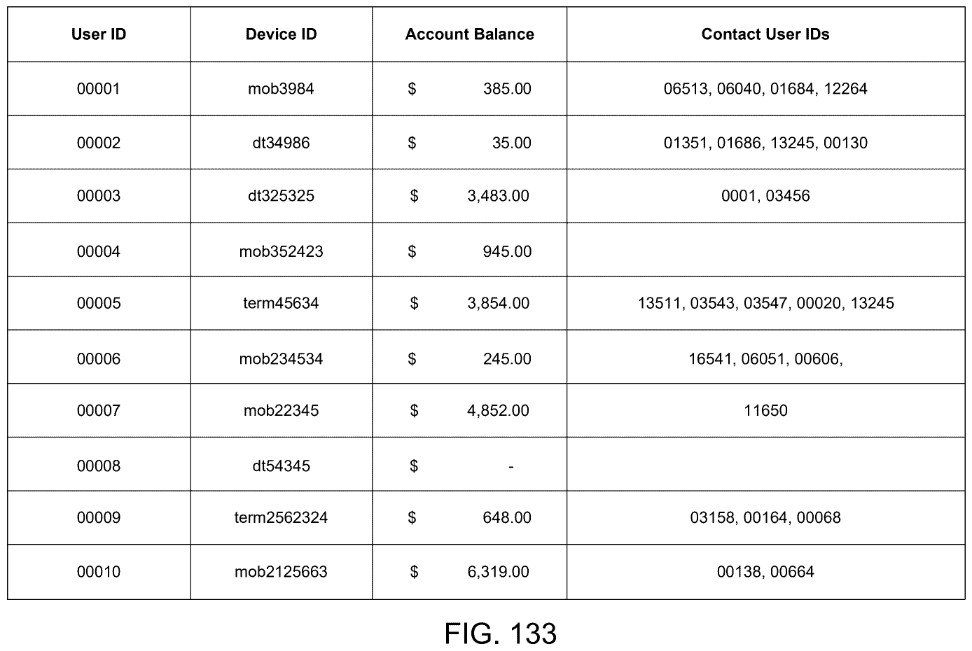

FIG. 133 illustrates a user database, according to an embodiment.

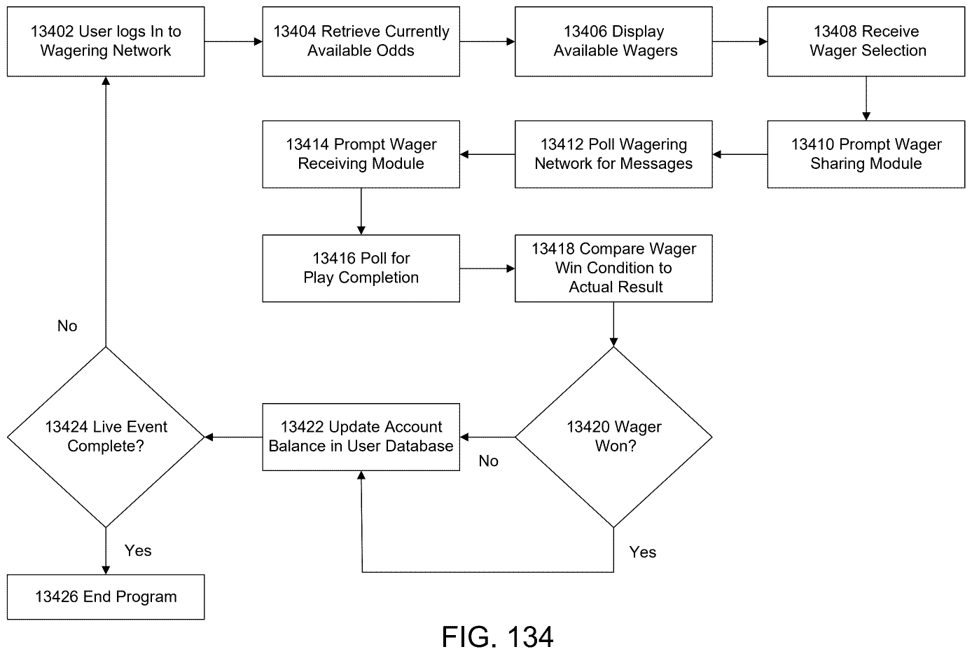

FIG. 134 illustrates a base wagering module, according to an embodiment.

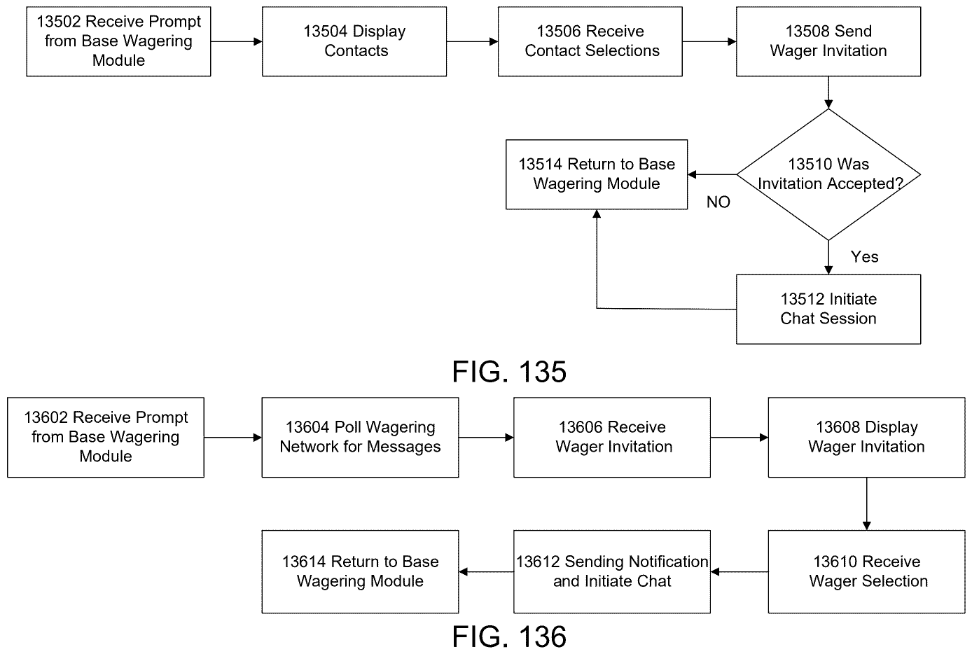

FIG. 135 illustrates a wager sharing module, according to an embodiment.

FIG. 136 illustrates a wager receiving module, according to an embodiment.

FIG. 132 is a system for a wager sharing and invitations. The system may include a live event 13202, for example a sporting event such as a football game, basketball game, baseball game, hockey game, tennis match, golf tournament, eSports or digital game, etc. The live event will include some number of actions or plays, upon which a user or bettor or customer can place a bet or wager, typically through an entity called a sportsbook. There are numerous types of wagers the bettor can make, including a straight bet, a money line bet, a bet with a point spread or line that bettor's team would need to cover, if the result of the game was the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 13202, such as the score of American football or the run line in baseball, or a series of action in the live event 13202. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live events 13202 in the future. Sportsbooks need to offer payment processing services in order to cash out customers. This can be done at kiosks at the live event 13202 or at another location.

Further, embodiments may include a plurality of sensors 13204 that may be used such as motion sensors, temperature sensors, humidity sensors, cameras such as an RGB-D Camera which is a digital camera capturing color (RGB) and depth information for every pixel in an image, microphones, radiofrequency receiver, a thermal imager, a radar device, a lidar device, an ultrasound device, a speaker, wearable devices etc. Also, the plurality of sensors 13204 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball.

Further, embodiments may include a cloud 13206 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance. The cloud 13206 may be communicatively coupled to wagering network 13208 which may perform real time analysis on the type of play and the result of the play. The cloud 13206 may also be synchronized with game situational data, such as the time of the game, the score, location on the field, weather conditions, and the like which may affect the choice of play utilized. For example, in other exemplary embodiments, the cloud 13206 may not receive data gathered from sensors 13204 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein.

Further, embodiments may include a wagering network 13208 which may perform real time analysis on the type of play and the result of a play or action. The wagering network 13208 (or cloud 13206) may also be synchronized with game situational data, such as the time of the game, the score, location on the field, weather conditions, and the like which may affect the choice of play utilized. For example, in other exemplary embodiments, a wagering network 13208 may not receive data gathered from sensors 13204 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 13208 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may utilize a user database 13210 which contains data relevant to all users of the system, which may include a user ID, a device identifier, a paired device identifier, wagering history, and wallet information for each user. The user database 13210 may additionally include a table of contacts for each user which are user IDs for other users who have been added by a user. The table of contacts may also include other relevant information for communicating with the contacts such as their user IDs for other social network platforms, email addresses and phone numbers.

Further, embodiments may include an odds calculation module 13212 which utilizes historical play data to calculate odds for in-play wagers.

Further, a historical plays database 13214, that contains play data for the type of sport being played in a live event 13202. For example, in American football, for optimal odds calculation, the historical play data should include meta data about the historical plays, such as time, location, weather, previous plays, opponent, physiological data, etc.

Further, embodiments may utilize an odds database 13216 that contains the odds calculated by the odds calculation module 13212, and the multipliers for distance and path deviation, and is used for reference by the base wagering module 13218 and to take bets from the user through a user interface and calculate the payouts to the user.

Further, embodiments may include a base wagering module 13218 that allows the user to place wagers on individual events in the live event 13202. The user may make a traditional wager on the event, such as wagering that the next play in an American football game will be a run instead of a pass. In this example the user is getting 2/1 odds on the run, meaning that for every $100 they wager, they will receive $200 if they win. The base wagering module 13218 can also allow users to share their wager with other users. The wager sharing module 13220 is called when a wager is place and may also be called upon a user winning a wager allowing the user to share their wager with a second user and invite the second user to place a wager on the same play and join a chat conversation with the user. The invitation receiving module 13222 is called when the base wagering module 13218 receives a message from the wagering network 13208 allowing the user to accept the invitation and place a wager on the same play as the user who sent the invitation and also join a chat conversation with the user who sent the invitation. Upon completion of a play, the base wagering module 13218 determines the result of wager and adjusts the balance of the user's account in the user database 13210 base upon the result of the wager.

Further, embodiments may include a wager sharing module 13220 that is prompted by the base wagering module 13218 when a user places a wager, providing to the user a list of contacts stored in the user database 13210 and allowing the user to select one or more contacts to invite to either make the same bet on the same play or to join a live synchronous or asynchronous messaging session to communicate and place future wagers during the live event 13202. The wager sharing module 13220 further receiving notification that the user the invited contact has elected to make the same bet and/or join the messaging session for the duration of part or all of the remainder of the live event 13202, or alternatively that the invitation has been rejected or timed out.

Further, embodiments may include an invitation receiving module 13222 that may be prompted by the base wagering module 13218 when the base wagering module 13218, upon polling a wagering network 13208 for received messages, receives a message from the wagering network 13208. The message can include at least an invitation to place a wager on the same play and additionally an invitation to join a chat conversation with the user who sent the invitation.

FIG. 133 illustrates the user database 13210. The user database 13210 stores data relevant to users of a wagering platform and may include any of a user ID, user's name, a device identifier, a wagering history and an account of funds for wagering. The user database 13210 may additionally contain contacts for each user such as in the form of user IDs for individuals whom the user has indicated to be acquaintances. The user database 13210 is used by the wager sharing module 13220 for selecting from the contacts in the user database 13210 with whom to share a wager invite. In an embodiment, the wager sharing module 13220 querying the user database 13210 to retrieve a list of contact user IDs associated with user Bob Jones, including the user ID for user Joe Smith, who user Bob Jones selects to receive a wager invitation. The user database 13210 is further used by the base wagering module 13218 to update the user's account of funds for wagering.

FIG. 134 illustrates the base wagering module 13218. The process begins with a user logging into the wagering network 13208 at step 13402 via a user interface by entering a username and a password. In an embodiment, the username is an email address and the password are a combination of alphanumeric characters. Current odds are retrieved at step 13404 for available wagers from an odds database 13216. Available wagers are displayed at step 13406 to a user via a wagering terminal. A wagering terminal may be any of a mobile device, notebook or desktop computer, or a proprietary computing device. A wagering terminal may further be any computing device with an internet connection. The available wagers, including a win condition, such as the offensive team in a football game completing a pass for a first down, and odds, such as 5/1, can be selected by a user. A wager is received from a user at step 13408 via a wagering terminal. The wager includes a wager amount such as $50, a win condition upon which a payout is made according to the odds, and odds, such as 5/1, in which case the user Bob Jones will receive a payout of five times their wager if the win condition is met during the play. At step 13410, the wager sharing module 13220 is prompted. The wager sharing module 13220 displays contacts from the user database 13210 and receives a selection of at least one contact from a user. The wager sharing module 13220 sends an invitation to the contact to place a wager and join a chat conversation via the play by play wagering platform and waits for a response. Upon receiving a response that the invitation was accepted, the wager sharing module 13220 initiates a chat conversation between the user and the contact and returning to the base wagering module 13218. Polling, at step 13412, is done to the wagering network 13208 for a message sent by another user. Prompting, at step 13414, is performed by the wager receiving module 13222 if a message is received from the wagering network 13208. The wager receiving module 13222 polls the wagering network 13208 for messages and receiving a wager invitation from a second user. The received wager invitation is displayed to the first user and a wager selection is received from the first user. Further, sending a notification that the invitation was accepted by the first user and initiating a chat conversation between the first and second user via the play by play wagering platform and returning to the base wagering module 13218 may be performed. Next, at step 13416 the plurality sensors 13204 may be polled for the completion of the play wagered upon by the user. In an embodiment, play completion may be signified by detection of a whistle blown by a referee in an American football game. Alternatively, play completion may be indicated by the ball returning to the hands of a pitcher and the pitcher returning to the pitching mound in a baseball game. Comparing, at step 134218, the wager win condition to the actual result of the play by polling the sensors 13204. In an embodiment, the wager win condition may be an American football team completing a pass for a first down and the actual result may be an American football team running for a gain of three yards. Determining, at step 13420, whether the wager was won. The wager is won if the actual result of the live event matches the win condition associated with the wager. In an embodiment the win condition may be an American football team completing a pass for a first down and the wager is won if the actual result includes a completed pass and a gain sufficient to advance the line of scrimmage past the first down line. If the wager is won, the base wagering module 13218 may further prompt the wager sharing module 13220 to invite another user to join future bets during the live event 13202 and a chat conversation. Updating the account balance of the user at step 13422 in the user database 13210 based on the result of the wager. If the wager is won, then increasing the account balance in an amount equal to the payout. The payout is determined based upon the odds accepted when the user placed the wager. In an embodiment, the odds are 5/1 and the wager amount is $50, so the payout would be $250. If the wager amount was not debited from the account balance prior to play completion, then adjusting the account balance by the difference between the wager amount and the payout. Similarly, if the wager was lost and the wager amount was not previously debited from the account balance, reducing the account balance by the wager amount. Polling the live event 13202 for event at step 13424 completion. The live event 13202 may be complete if a video feed is terminated or alternatively if the sensors 13204 detect a succession of whistle sounds from a referee in an American football game signaling the end of a game. If the event is not complete, return to step 13404. Ending the program at step 13228 if the live event 13202 is complete.

FIG. 135 illustrates the wager sharing module 13220. The process begins with receiving a prompt, at step 13502, from the base wagering module 13218 that the user has placed a wager. The wager includes a wager amount, a win condition and odds. In an embodiment, the wager amount is $50, the win condition is an American football team completing a pass for a first down and the odds are 5/1. Alternatively, wager sharing module 13220 can include receiving a prompt from the base wagering module 13218 that the user has won a wager. Querying the user database 13210 may be done at step 13504 to determine contacts associated with the user and displaying the contacts to the user. Each contact may include a name and a profile picture. The contact may additionally include wagering history, such as the total number of wagers the individual has placed on the play by play wagering platform and total amount of money won on previous wagers as well as the contacts times zone or current availability, such as whether the contact is currently online on the platform or offline. Receiving a selection, at step 13506, of one or more contacts from the user may be performed. Sending a wager invitation, at step 13508, to the selected one or more contacts may also be performed. The wager invitation can include details of the wager placed by the user including the win conditions and odds. The wager invitation may additionally include the wager amount. The wager invitation prompts the one or more contacts to place a wager on the play and further join a chat conversation with the user who selected the contact to receive an invitation. In an embodiment, the invitation prompts the contact, user Joes Smith, to wager on the same play as the user Bob Jones. Polling of the wagering network 13208, may be done at step 13510, for a message confirming that a contact accepted the invitation. The confirmation message may include details of a wager placed by the contact. If the received message alternatively declined the invitation, the wager sharing module 13220 may be exited and could be returned to the base wagering module 13218. If the invitation was accepted, initiating a chat session at step 13512, between the user Bob Jones and the contact from whom a message accepting the invitation was received, user Joe Smith, may be performed. The chat session may be any of a voice, video or text chat. In an embodiment, the chat session is a voice chat session. Returning, at step 13514, to the base wagering module 13218.

FIG. 136 illustrates the wager receiving module 13222. The process begins with receiving a prompt at step 13602 from the base wagering module 13218 that the base wagering module 13218 received a message from the wagering network 13208. Polling the wagering network 13208 can be next, at step 13604, to check for messages. The messages may include an invitation to place a wager or join a chat conversation. Receiving a wager invitation may be done at step 13606, including an invitation to place a wager on the same play as another user's wager and an invitation to join a chat conversation with the other user. In an alternate embodiment, the invitation may include the successful results of another user's wager and an invitation to place a wager on a future play in the live event 13202. The wager invitation may be displayed, at step 13608, to the user. The invitation further prompts the user Joe Smith to place a wager and join a chat conversation. In an embodiment, the wager includes a win condition that an American football team will complete a pass for a first down, and odds of 5/1. Further, the chat conversation invite may prompt for any of a text, voice or video conversation. A wager selection may be received, at step 13610, from a user. The wager selection includes acceptance of a win condition, odds, and a wager amount. In an embodiment, the win condition is an American football team completing a pass for a first down with odds of 5/1, and a wager amount of $100 such that the payout from the wager will be $500 if the win condition occurs. The user Joe Smith may alternatively decline the wager selection by rejecting the invitation or allowing the invitation to timeout. Sending, at step 13612, a notification to and initiating a chat conversation with the user Bob Jones who originated the wager invitation may then occur. The chat conversation may be any of a text, voice or video conversation. Returning, at step 13614, to the base wagering module 13218, may then be done.

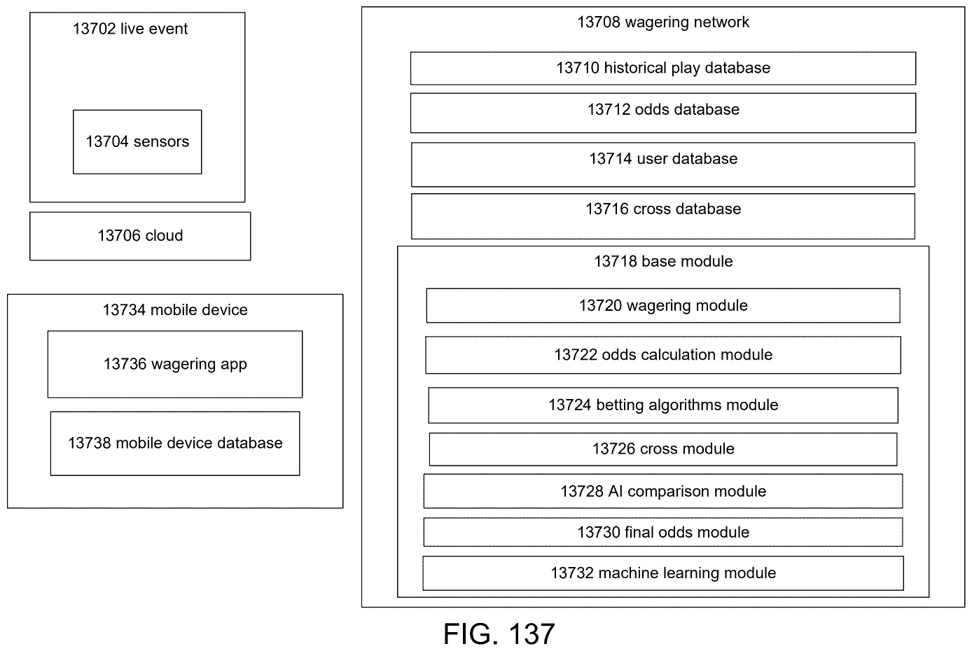

FIG. 137 illustrates a system for an AI sports betting algorithms engine, according to an embodiment.

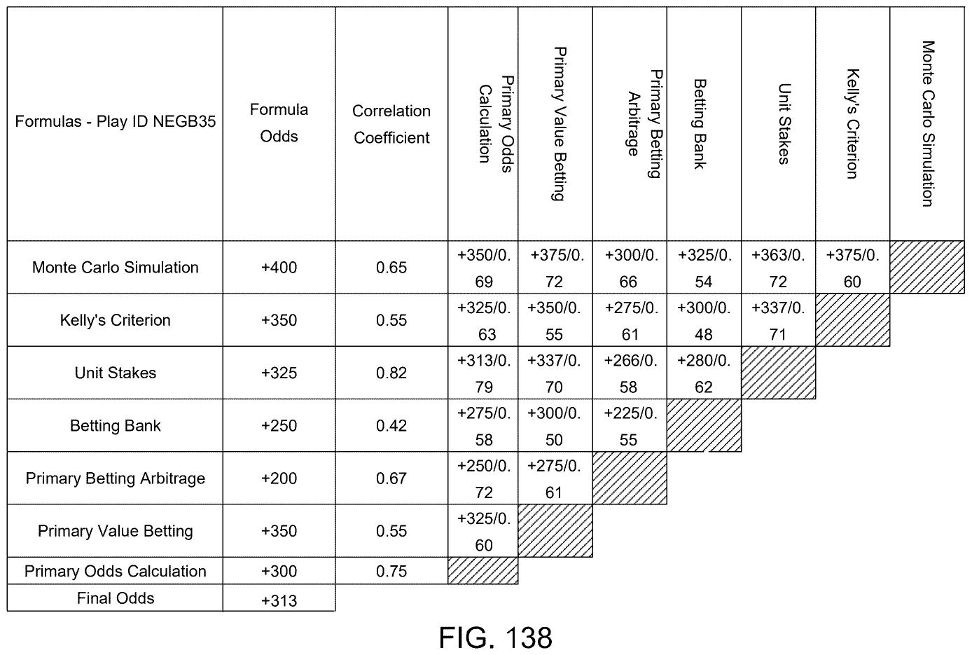

FIG. 138 illustrates a cross database, according to an embodiment.

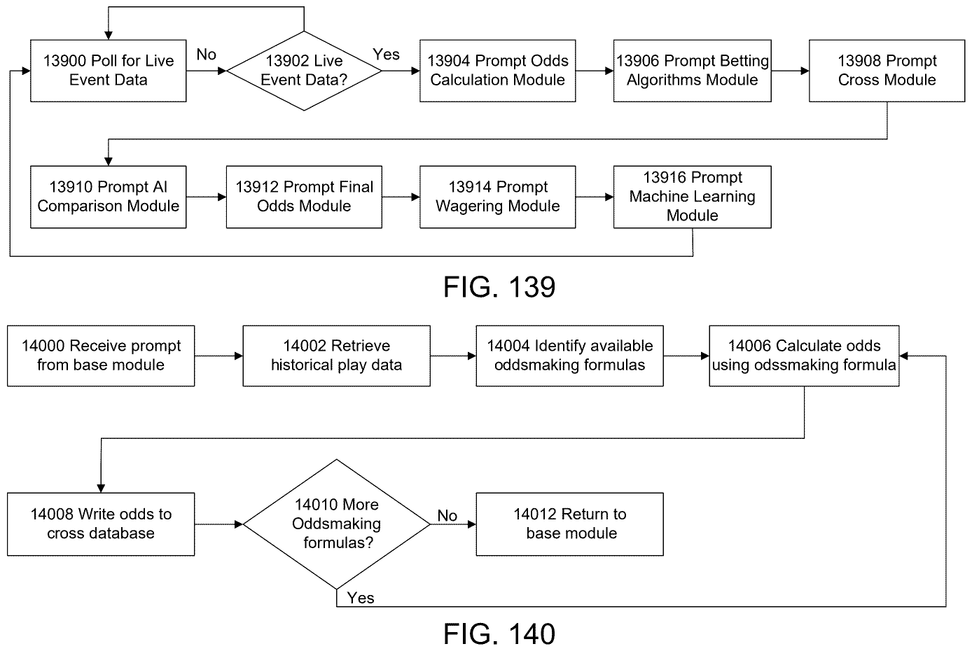

FIG. 139 illustrates a base module, according to an embodiment.

FIG. 140 illustrates a betting algorithms module, according to an embodiment.

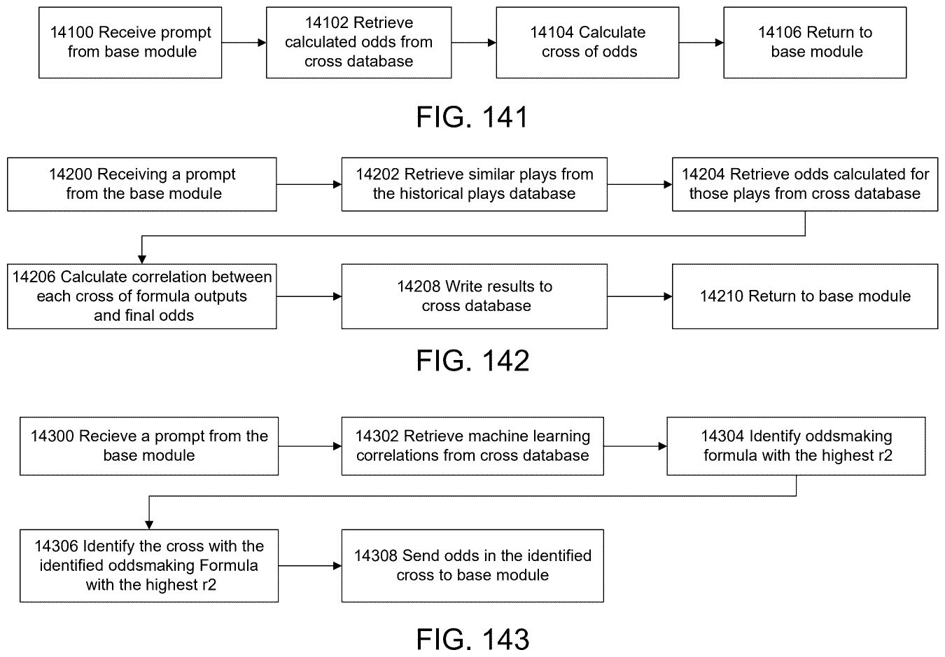

FIG. 141 illustrates a cross module, according to an embodiment.

FIG. 142 illustrates an AI comparison module, according to an embodiment.

FIG. 143 illustrates a final odds module, according to an embodiment.

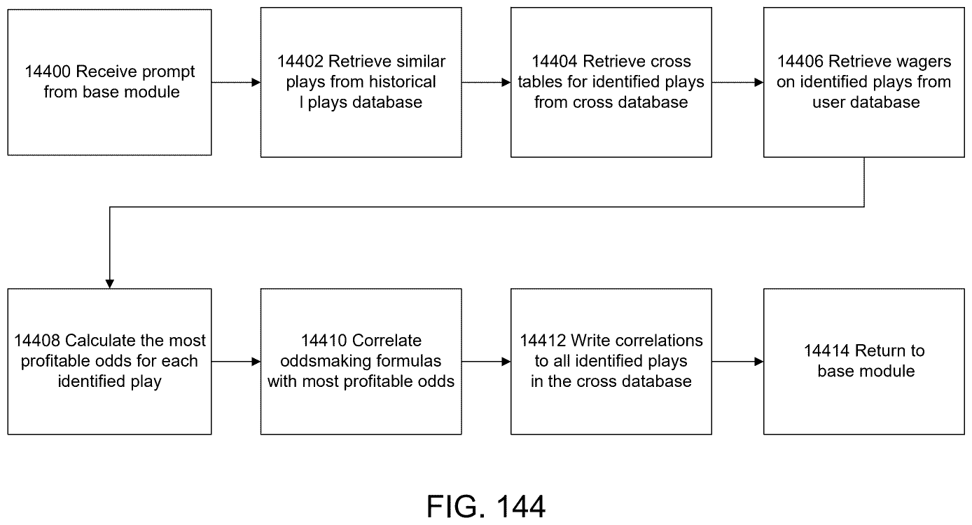

FIG. 144 illustrates a machine learning module, according to an embodiment.

FIG. 137 displays a system for an AI sports betting algorithms engine. This system may be comprised of a live event 13702, for example a sporting event such as a football game, basketball game, baseball game, hockey game, tennis match, golf tournament, eSports or digital game, etc. The live event 13702 will include some number of actions or plays, upon which a user or bettor or customer can place a bet or wager, typically through an entity called a sportsbook. There are numerous types of wagers the bettor can make, including a straight bet, a money line bet, a bet with a point spread or line that bettor's team would need to cover, if the result of the game was the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets, that are added games, that often allow the user to customize their betting by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event, such as the score of American football or the run line in baseball, or a series of action in the live event 13702. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a better to bet on both sides at different point spreads in order to middle and win both bets. Sportsbooks will often offer bets on portions of games, such as first half bets and half-time bets. Additionally, the sportsbook can offer futures bets on live events 13702 in the future. Sportsbooks need to offer payment processing services in order to cash out customers. This can be done at kiosks at the live event 13702 or at another location.

Further, embodiments may include a plurality of sensors 13704 that may be used such as motion sensors, temperature sensors, humidity sensors, cameras such as an RGB-D Camera which is a digital camera capturing color (RGB) and depth information for every pixel in an image, microphones, a radiofrequency receiver, a thermal imager, a radar device, a lidar device, an ultrasound device, a speaker, wearable devices etc. Also, the plurality of sensors 13704 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball.

Further, embodiments may include a cloud 13706 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, for example over Internet, and relies on sharing of resources to achieve coherence and economics of scale, like a public utility, while third-party clouds enable organizations to focus on their core businesses instead of expending resources on computer infrastructure and maintenance. The cloud 13706 may be communicatively coupled to a wagering network 13708 which may perform real time analysis on the type of play and the result of the play. The cloud 13706 may also be synchronized with game situational data, such as the time of the game, the score, location on the field, weather conditions, and the like which may affect the choice of play utilized. For example, in other exemplary embodiments, the cloud may not receive data gathered from the plurality of sensors 13704 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein.

Further, embodiments may include the wagering network 13708 which may perform real time analysis on the type of play and the result of a play or action. The wagering network 13708 (or cloud 13706) may also be synchronized with game situational data, such as the time of the game, the score, location on the field, weather conditions, and the like which may affect the choice of play utilized. For example, in other exemplary embodiments, the wagering network 13708 may not receive data gathered from the plurality of sensors 13704 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 13708 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may include a historical play database 13710, that contains play data for the type of sport being played in the live event 13702. For example, in American Football, for optimal odds calculation, the historical play data 13710 may include meta data about the historical plays, such as time, location, weather, previous plays, opponent, physiological data, etc.

Further, embodiments may utilize an odds database 13712 that contains the odds calculated by an odds calculation module 13722, and the multipliers for distance and path deviation, and is used for reference by the base module 13718 and to take bets from the user through a user interface and calculate the payouts to the user.

Further, embodiments may utilize a user database 13714 which contains data relevant to all users of the system, which may include, a user ID, a device identifier, a paired device identifier, wagering history, and wallet information for each user.

Further, embodiments may include a cross database 13716 which contains the output of a betting algorithms module 13724, a cross module 13726, an AI comparison module 13728, a final odds module 13730, and a machine learning module 13732, as well as the mechanisms of the odds making formulas used to by the betting algorithms module 13724 for all previous plays where the wagering network 13708 has offered wagers on at least one outcome.

Further, embodiments may include the base module 13718 that controls the order of operations of the other modules and databases on the wagering network 13708, and well as enables the flow of information about the live event 13702 from either the plurality of sensors 13704, the cloud 13706 or some combination of those. The base module 13718 also enables the interaction of a wagering app 13736 on a mobile device 13734.

Further, embodiments may include a wagering module 13720 that presents wagers available from the wagering network 13708, to users of the wagering app 13736, collects their wagers, and compares the wagers to the actual results and the odds in order to adjust the user's account balance in the user database 13714.

Further, embodiments may include the odds calculation module 13722 which utilizes historical play data to calculate odds for in-play wagers.

Further, embodiments may include the betting algorithms module 13724 that calculates the odds on at least one possible outcome of a play inside of the live event 13702, using at least one additional odds making formula than the one used by the odds calculation module 13722.

Further, embodiments may include the cross module 13726 that calculates at least one combination of the odds created by the different odds making formulas in the betting algorithms module 13724.

Further, embodiments may include an AI comparison module 13728 that calculates the correlation between each cross of odds making formulas in the cross database 13716, as calculated by the cross module 13726, and the final odds on each of the identified similar plays. In an example a trendline is plotted using the final odds on all identified similar plays. The odds calculated by crossing each odds making formula are then compared to that trendline.

Further, embodiments may include the final odds module 13730 that identifies the odds making formula with the highest correlation to the most profitable odds on similar plays, then identifies the cross of that odds making formula's odds with another odds making formula is order to offer the best possible odds through the wagering module 13720.

Further, embodiments may include the machine learning module 13732 that compares the actual results of plays in the live event 13702 with the odds created by each odds making formula and the crosses between those formulas in order to identify the odds that are the most profitable for the wagering network 13708. The profitability of each of the odds making formula odds is compared to the most profitable odds calculated in order to identify the odds making formula most highly correlated with the most profitable odds on similar plays.

Further, embodiments may include the mobile device 13734 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices provide for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 13734 could be an optional component and would be utilized in a situation in which a paired wearable device is utilizing the mobile device 13734 as additional memory or computing power or connection to the internet.

Further, embodiments may include the wagering app 13736, which is a program that enables the user to place bets on individual plays in the live event 13702, and display the audio and video from the live event 13702, along with the available wagers on the mobile device 13736. The wagering app 13736 allows the user to interact with the wagering network 13708 in order to place bets and provide payment/receive funds based on wager outcomes.

Further, embodiments may include a mobile device database 13738 that may store user data, historical play data, primary odds, data etc.

FIG. 138 illustrates the cross database 13716. The cross database 13716 contains the output of the betting algorithms module 13724, the cross module 13726, the AI comparison module 13728, the final odds module 13730, and the machine learning module 13732, as well as the mechanisms of the odds making formulas used to by the betting algorithms module 13724. The wagering network 13708 may use some number of odds making formulas. In this example the wagering network 13708 is using seven odds making formulas; the primary odds calculation output from the odds calculation module 13722 based on the information available in the historical plays database 13714, a primary value betting formula, a primary betting arbitrage formula, a betting bank formula, a unit stakes formula, a Kelly's criterion formula, and a Monte Carlo simulation. Formulas could be, for example, formulas that are in and of themselves computer program modules designed to find profitable sports betting opportunities. These formulas use vast amounts of data from past sporting matches so as to identify patterns, which can then be used to calculate the probability of certain sporting outcomes. In most cases, primary betting algorithms calculate the probability of various outcomes, and compare those probabilities to the odds offered by bookmakers, so as to identify bets that are worth placing. Primary betting algorithms can be divided into two types, depending on what they aim to achieve, these are, value betting formulas and betting arbitrage formulas. Primary value betting formulas are used on any bet where the odds for a certain outcome seem favorable, based on the probability of that outcome occurring. There are plenty of value betting formulas that collect data from past sporting matches, and use it estimate the probability of various outcomes. There are two parts to a value betting formula. First, the formula needs to identify value bets, which relates to the idea of expected value. Second, the formula needs to suggest an appropriately sized bet, depending on how confidently the bet could be made. Finding value bets is all about finding bets with an expected value greater than the stake of the bet. The expected value of a bet is the profit or loss you can expect to make when placing a bet over and over again. With a value bet, the odds provided are high enough that you should make a profit based on your estimation of the outcome's probability. In order to calculate the expected value of a bet—and thus identify value bets-betting formulas rely on past data. By looking at how often a certain outcome occurred in past matches, and analyzing the trends within those matches, formulas can predict what will happen in an upcoming match. For example, if a football team scores an average of 2.1 goals every game, you can expect them to score more than two goals in an upcoming match. Primary betting arbitrage formulas are used when advantage is sought for changing odds for a certain sporting outcome. For example, it usually is used when using “betting exchanges”, where betters can place a bet at favorable odds, and then place a bet against their original bet (thereby guaranteeing a profit) once the odds have moved. These algorithms are the primary betting arbitrage that is used when “patterns in odds” can be determined. Many professional betters like to have a set betting bank (size varies depending on wealth) from which they place all their bets. This allows them to easily keep track of profit and loss because all winnings and losses are coming from the same bank. It also allows them to stake set proportions of their bank on bets which reflect their confidence in the selection's chances. Profit from the bank are periodically withdrawn or withdrawn when it reaches a certain amount to be used for non-betting purposes. For example, a user may have a betting bank of 1000 dollars, from which the user may withdraw profit every time the bank reaches 1500 dollars, or instead whatever profit has been made each three months. Formulas such as this would look at the database of players banks and could change the odds if there is lots of money in the bank vs. less money bank. Assigning unit stakes to bets can be useful as it makes the better more disciplined and less likely to over bet an event. Sometimes a maximum and minimum unit stake is used, from one unit to twenty units for example. Depending on the seriousness of the punter a unit may be 1, 10, 100 dollars or even more. These units are usually referred to as points. The more disciplined a better the smaller the band of units they will probably use. This makes them even less likely to over or under bet an outcome as the difference in confidence between units will be even more clearly defined in their mind. For example, a user may have stakes varying from 1 to 5 points. Each point is worth 20 dollars. A minimum bet for a user would be 20 dollars and a maximum bet would be 100 dollars. Formulas such as this would look at the database of players unit stakes and could change the odds if there are larger range of unit stakes vs less range of unit stakes. Kelly's Criterion is a formula that is used to determine how much of a bank should be risked on a given bet. The formula considers the odds of the bet and the probability that it will win and the probability that it will lose. This does have the advantage of ensuring the whole bank is never lost on a bet and helps to steadily increase the bank. A disadvantage of this is that there is no way of guaranteeing that money won't be lost. In fact, there is a 1/3 chance of halving the bankroll before it is doubled. A Monte Carlo simulation (MCS) is a system used by punters to help forecast the outcome of a wager. Working as a model of chance, the system uses a computer algorithm to run simulations in order to obtain the probability of a wager. This is done by converting uncertainties into probability by simulating a model numerous times to get a firm conclusion of probability. What MCS does is input the variables of a model into probability distributions and then randomly selects from them, essentially working in a similar way to wisdom of the crowd where the more one guesses, the closer to the result the system will be. For example, using the Monte Carlo method to determine whether the Patriots will win in a game versus the Giants. The system can add various parameters to the system, all of which could influence the result of the game. For example, weather, head-to-head form, injuries, or the starting quarterback could all have an impact. The system can then allow the function and system to run its course and spit out a more accurate probability of the Patriots winning. The betting algorithms module 13724 may run some or all of the available betting formulas for each possible outcome of an available wager to populate the formula odds column of the cross database 13716. In this example the table contains data related to the 35th play of an American football game between the New England Patriots and the Green Bay Packers being a run. In this example the odds returned by the odds calculation module 13722 based on the information in the historical play database 13710 are +300 on a run. In this example the MCS returned odds of +400 on the same play resulting in a run. Each available formula is crossed against each other formula by the cross module 13726 to create blended odds. Those odds could be blended simply by taking the midpoint between the two odds but could also be weighted towards one or the other or mixed in some other fashion. In this example, the cross between the primary odds calculation odd of +300 and the MCS odds of +400, is +350. The AI comparison module 13728 populates each cross cell with a correlation coefficient relating to each cross of odds being correct in the context of this play. In this example, the cross between the primary betting arbitrage odds formula of +200 and the primary value betting formula of +350 has a correlation coefficient of 0.61 with the final odds in similar historical plays. Similar plays can be defined in a number of different ways based on characteristics of the play, game, players involved, weather, etc. In this example, similar plays are defined as having the same down and distance to go in the same quarter of a game. Finally, the machine learning module 13732 may compare the final odds to the actual result and to the odds produced by each odds making formula.

FIG. 139 illustrates the base module 13718. The process begins with the base module 13718 polling, at step 13900, the cloud 13706 or the sensors 13704 for new data related to the live event 13702. If there is not data for the live event 13702 the module returns, at step 13702, to step 13900 and continues to poll for new data. If there is data from the live event 13702 the module prompts, at step 13904, the odds calculation module 13722. The module then prompts, at step 13906, the betting algorithms module 13724 which calculates odds on the next play in the live event 13702 using at least two different odds making formulas. The module then prompts, at step 13908, the cross module 13726 to blend the results of each of the odds making formulas used by the odds calculation module 13722. The module then prompts, at step 13910, the AI comparison module 13728 to calculate the correlation between each cross off odds making formulas and the final odds in a similar play. The module then prompts, at step 13912, the final odds module 13730 to select the odds from the cross database 13716 to offer through the wagering module 13720. The module then prompts, at step 13914, the wagering module 13720 and provides the final odds selected by the final odds module 13730. The module then prompts, at step 13916, the machine learning module 13732 which compares the final odds selected by the final odds module 13730 to the actual results. The same comparison is made between the odds calculated by each other odds making formula and the actual result in similar plays. The module then returns to step 13900 to continue polling data for the live event 13702.

FIG. 140 illustrates the betting algorithms module 13724. The process begins with the betting algorithms module 13724 receiving, at step 14000, a prompt from the base module 13718 that there is a play in the live event 13702 where wagers may be placed upon at least one outcome. The module may then retrieve, at step 14002, data from the historical play database 13710 needed by the odds making formulas. It should be obvious that data beyond historical play data may be used by one or more of the odds making formulas. This data could include data from the user database 13714 about the users and their wagering history, current account balances, etc. The data may also include 3rd party analytics or other information related to the live event 13702, wagers, or users. The module then identifies, at step 14004, the odds making formulas in the cross database 13716 that are available to calculate odds to offer on a play in the live event 13702. In this example all of the formulas in the cross database 13716 are used for each wagering option, but it should be obvious that different odds making formulas could be used, or only a subset of the available formulas could be used, and that subset could also change based on the context of the live event 13702 or for other reasons, such as the current handle or amount of exposure of the wagering network 13708. The module then calculates, at step 14006, the odds on the at least one outcome of a play in the live event 13702 using the first available odds making formula. The module will loop back to this step for each odds making formula that will be used to calculate the odds. The module then writes, at step 14008, the calculated odds to the cross database 13716. The module then determines, at step 14010, if there are more odds making formulas available in the cross database 13716 that have not yet been used to calculate the odds on the at least one outcome of a play in the live event 13702. If there are more odds making formulas available, the module returns to step 14006. If there are no more odds making formulas that are to be used at this time, the module returns, at step 14012, to the base module 13718.

FIG. 141 illustrates the cross module 13726. The process begins with receiving, at step 14100, a prompt from the base module 13718 that odds have been calculated using at least two odds making formulas by the betting algorithms module 13724. The module then retrieves, at step 14102, the odds calculated by the betting algorithms module 13724 from the cross database 13716. The module then calculates, at step 14104, the cross between each set of calculated odds. In this example, the odds calculated by the primary value betting formula +350 on the New England Patriots to run on the 35th play of their game against the Green Bay Packers. The MCS calculated odds of +400 on the same play. The cross between these two odds is calculated as +375. While the midpoint between the two odds is used as the cross in this example, it should be obvious that there are different ways to calculate the cross between the two odds. For example, one of the two could be weighted more heavily than the other. The lower odds, or higher odds could be favored by default. The odds closer to the primary odds calculation could be favored, or other variations of crossing the odds. This is done for each set of odds created against every other set of odds created. When all of the crosses between each set of calculated odds have been calculated and written to the cross database 13716, the module then returns, at step 14106, to the base module 13718.

FIG. 142 illustrates the AI comparison module 13728. The process begins with the module receiving, at step 14200, a prompt from the base module 13718 that there is a play in the live event 13702 that wagers may be placed upon at least one outcome. The module then retrieves, at step 14202, plays similar to the current play that odds are being calculated for, from the historical play database 13710. Similar plays can be defined in a number of different ways. In this example, a similar play is a play with the same down and distance to go, in the same half of a game. It should be obvious that a similar play can be defined in other ways, such as with a similarity score, or other plays involving the same offense or the same defense, or based on the stadium the game is played in, or the current weather, or the score of the game, or in a number of other ways. The module then retrieves, at step 14204, the odds calculated by the available ordaining formulas for the identified similar plays. The odds created by crossing the odds created by each odds making formula is also retrieved from the cross database 13716. The module then calculates the correlation between each cross of odds making formulas in the cross database 13716, as calculated by the cross module 13726, and the final odds on each of the identified similar plays. In this example a trendline is plotted using the final odds on all identified similar plays. The odds calculated by crossing each odds making formula are then compared to that trendline. If the odds for a particular cross of odds making formulas exactly matches the final odds on all of the previous plays the correlation between that cross of odds making formulas and the final odds would have an r-squared value of 1.0. The greater the difference between the two data sets, the closer to zero the r-squared value becomes, indicating a lower correlation. This is done in order to identify the cross of odds making formulas that is most correlated with the final odds in the current context. In this example, the cross between the betting bank formula and the Kelly's criterion formula has the lowest correlation to the final odds on similar plays, with a r-squared value of 0.48. The cross between the unit stakes odds and the primary odds calculation has the highest correlation to the final odds with a r-squared value of 0.79. While correlation is used in this example, it should be obvious that other types of comparisons can be made, such as convolution, regression, etc. The calculated correlation coefficients are then written, at step 14208, to the cross database 13716. The module then returns, at step 14210, to the base module 13718.

FIG. 143 illustrates the final odds module 13730. The process begins with the module receiving, at step 14300, a prompt from the base module 13718 that there is a play in the live event 13702 where wagers may be placed upon at least one outcome. The module then retrieves, at step 14302, the output of the machine learning module on the similar historical plays for each of the odds making formulas. The module then identifies, at step 14304, the odds making formula with the highest r-squared value, indicating that it is the odds making formulas who's previous results are the most highly correlated with the actual results of the identified similar previous plays. In this example, the odds returned by the unit stakes formula were the most highly correlated to the actual results of plays similar to the current play, as represented by the r-squared value of 0.82. This is calculated by the machine learning module 13732 which may examine the final odds offered on the wagering network 13708, and the odds of some or all of the available odds making formulas, on all previous plays that are similar to the current play. The module then identifies, at step 14306, the cross with the identified odds making formula that has the highest correlation who's previous results are the most highly correlated to the final odds, as indicated by the r-squared value that is calculated by the AI comparison module 13728. In this example, the unit stakes formula was identified at step 14304, and the cross with the unit stakes formula that has the highest r-squared value is the primary odds calculations, with a r-squared of 0.79. This cross has odds of +350 on a run on the next play. The odds identified, in this example +350, is sent, at step 14308, to the base module 13718.

FIG. 144 illustrates the machine learning module 13732. The process begins with receiving, at step 14400, a prompt from the base module 13718 that there is a play in the live event 13702 where wagers have been placed upon at least one outcome. The module then retrieves, at step 14402, the similar plays used by the AI comparison module 13728 from the historical plays database 13710. The module then retrieves, at step 14404, the cross tables for the plays identified at step 14402 from the cross database 13716. The module then retrieves, at step 14406, the wagers placed on the identified plays from the user database 13714. The module then calculates, at step 14408, the odds that would produce the most profit, or least loss, for the wagering network 13708 based on the amount wagered on that play. This may be done by using the amount of money wagered on a given outcome, the actual outcome, and the odds produced by each of the odds making formulas in the betting algorithms module 13724. It should be obvious that there are additional variable that may be considered, such as the impact of the different odds on the action that is placed on a given outcome. The module then calculates, at step 14410, the correlation between the odds created by each odds making formula and the most profitable odds for each of the identified historical plays that are similar to the play that was just wagered on through the wagering module 13720. The correlation coefficient, represented as a r-squared value between zero and one, is between the profitability of each odds making formula. In this example the primary value betting formula was less correlated with the most profitable odds, with a r-squared value of 0.55, than the unit stakes formula, which had a r-squared value of 0.82 when correlated with the most profitable odds on all identified similar plays in the historical plays database 13710. The module then writes, at step 14412, the correlation, expressed as a r-squared value in this example, to the table for each identified similar play in the cross database 13716. It should be obvious that there are other ways in which machine learning, or AI can be applied to the historical performance of odds in a given context. For example, instead of the odds that would create the most profit for the wagering network 13708, the correlation could be to the odds that created the greatest handle, or the largest number of wagers. The module then returns, at step 14414, to the base module 13718.

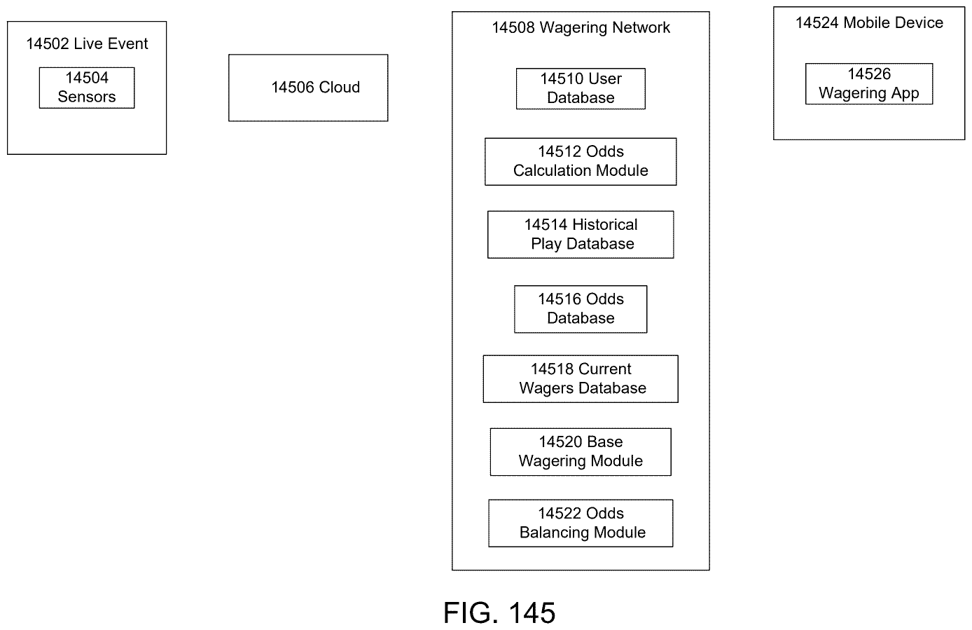

FIG. 145 illustrates a system for a wager odds balancing method, according to an embodiment.

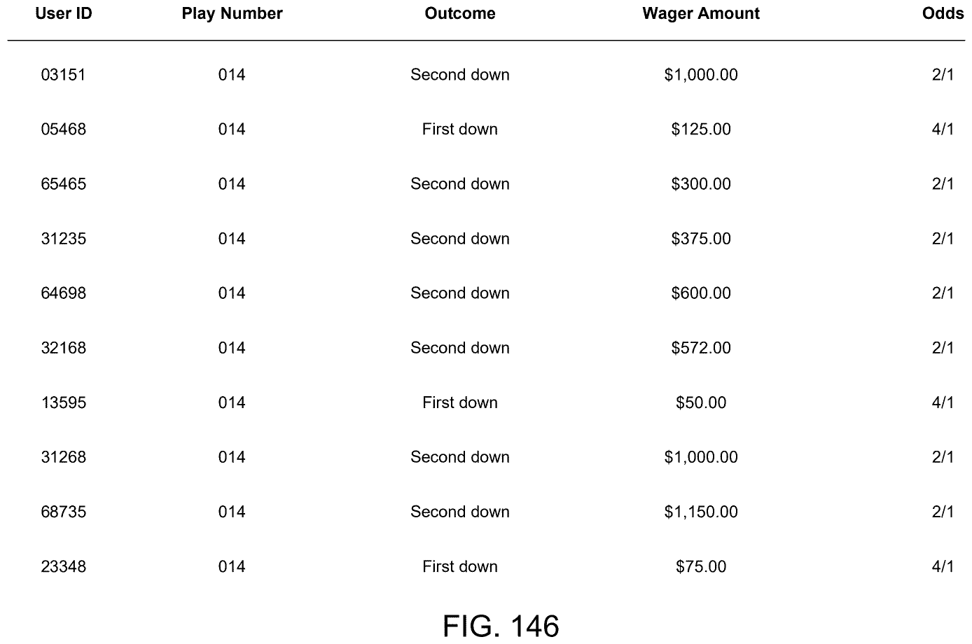

FIG. 146 illustrates a current wagers database, according to an embodiment.

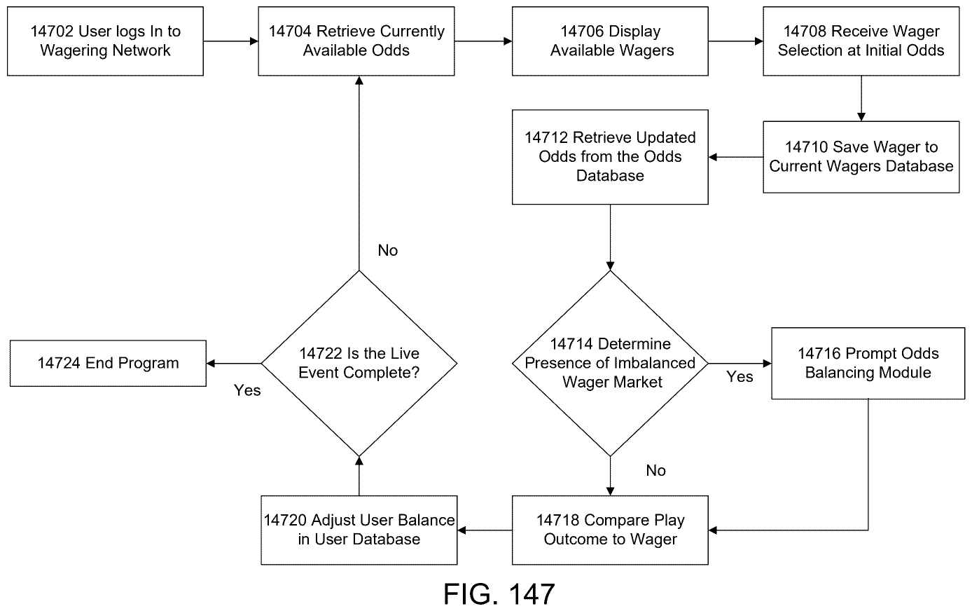

FIG. 147 illustrates a base wagering module, according to an embodiment.

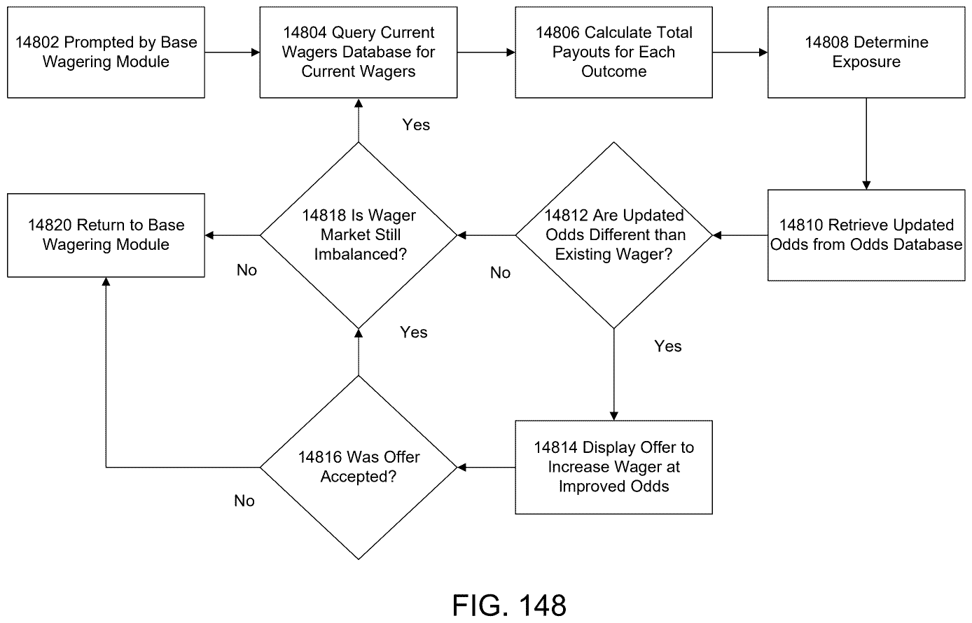

FIG. 148 illustrates a odds balancing module, according to an embodiment.

FIG. 145 is a system for a wager odds balancing method. This system comprises of a live event 14502, for example a sporting event such as a football game, basketball game, baseball game, hockey game, tennis match, golf tournament, eSports or digital game, etc. The live event will include some number of actions or plays, upon which a user, bettor or customer can place a bet or wager, typically through an entity called a sportsbook. There are numerous types of wagers the bettor can make, including, a straight bet, a money line bet, a bet with a point spread or line that bettor's team would need to cover, if the result of the game was the same as the point spread the user would not cover the spread, but instead the tie is called a push. If the user is betting on the favorite, they are giving points to the opposing side, which is the underdog or longshot. Betting on all favorites is referred to as a chalk, this is typically applied to round robin, or other styles of tournaments. There are other types of wagers, including parlays, teasers, and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event, such as the score of American football or the run line in baseball, or a series of action in the live event. Sportsbooks have a number of bets they can handle, a limit of wagers they can take on either side of a bet before they will move the line or odds off of the opening line. Additionally, there are circumstances, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live events in the future. Sportsbooks need to offer payment processing services in order to cash out customers. This can be done at kiosks at the live event or at another location.

Further, embodiments may include a plurality of sensors 14504 that may be used such as motion sensors, temperature sensors, humidity sensors, cameras such as an RGB-D Camera which is a digital camera capturing color (RGB) and depth information for every pixel in an image, microphones, a radiofrequency receiver, a thermal imager, a radar device, a lidar device, an ultrasound device, a speaker, wearable devices etc. Also, the plurality of sensors 14504 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball.

Further, embodiments may include a cloud 14506 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, for example over Internet, and relies on sharing of resources to achieve coherence and economics of scale, like a public utility, while third-party clouds enable organizations to focus on their core businesses instead of expending resources on computer infrastructure and maintenance. The cloud 14506 may be communicatively coupled to a wagering network 14508 which may perform real time analysis on the type of play and the result of the play. The cloud 14506 may also be synchronized with game situational data, such as the time of the game, the score, location on the field, weather conditions, and the like which may affect the choice of play utilized. For example, in some exemplary embodiments, the cloud 14506 may not receive data gathered from sensors and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein.

Further, embodiments may include the wagering network 14508 which may perform real time analysis on the type of play and the result of a play or action. The wagering network 14508 (or cloud 14506) may also be synchronized with game situational data, such as the time of the game, the score, location on the field, weather conditions, and the like which may affect the choice of play utilized. For example, in some exemplary embodiments, the wagering network 14508 may not receive data gathered from sensors and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 108 can offer a number of software managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may utilize a user database 14510 which contains data relevant to all users of the system, which may include a user ID, a device identifier, a paired device identifier, wagering history, and wallet information for each user.

Further, embodiments may include an odds calculation module 14512 which utilizes historical play data to calculate odds for in-play wagers.

Further, embodiments may include a historical plays database 14514, which contains play data for the type of sport being played in a Live Sporting Event 14502. For example, in American Football, for optimal odds calculation, the historical play data should include meta data about the historical plays, such as time, location, weather, previous plays, opponent, physiological data, etc.

Further, embodiments may utilize an odds database 14516 that contains the odds calculated by the odds calculation module 14512, with multipliers for things such as distance and path deviation, and which is used for reference by the base wagering module 14520 to take bets from the user through a user interface and calculate the payouts to the user.

Further, embodiments may utilize a current wagers database 14518 that contains wagers during a live event 14502. Wagers may include a wager amount, odds, and an outcome such that a payout, in the amount of the wager amount multiplied by the odds, will be paid to a user if the outcome wagered on occurs, otherwise the wager amount being lost.

Further, embodiments may include the base wagering module 14520 which allows a user to place wagers on individual events in the live event 14502. The user may make a traditional wager, such as wagering that the next play in an American football game will be a run instead of a pass. In this example the user is getting 2/1 odds on the run, meaning that for every $100 they wager, they will receive $200 if they win. The base wagering module 14520 further queries the current wagers database 14518 for the presence of an imbalanced wager market such that the exposure of a wagering network 14508 from one outcome exceeds a threshold for an individual event or play and triggers the odds balancing module 14522 when such an imbalance is detected. Upon completion of a play, the base wagering module 14520 determines the result of wager and adjusts the balance of the user's account in the user database 14510 based upon the result of the wager.

Further, embodiments may include the odds balancing module 14522 that receives a prompt from the base wagering module 14520 that an imbalanced wager market is present, such that the exposure to a wagering network 14508 of one outcome exceeds a threshold. The odds balancing module 14522 queries the current wagers database 14518 for wagers placed on the next play at the live event 14502 and determines an amount of wagers needed to correct the imbalanced wager market. Updated odds are retrieved from the odds database 14516 and an offer is made to a user to increase their existing wager such that the entirety of the original wager amount and the wager increase amount would be wagered at the updated odds. the odds balancing module 14522 continues to check for an imbalanced wager market and returns to the base wagering module 14520 when an imbalanced wager market is no longer present.

Further, embodiments may include a mobile device 14524 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices provides for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a Fire Wire bus, an Ethernet bus, a Gigabit Ethernet bus, a Fiber Channel bus, or a Thunderbolt bus. In some embodiments the mobile device 14524 could be an optional component and would be utilized in a situation in which a paired wearable device is utilizing the mobile device 14524 as additional memory or computing power or connection to the internet.

Further, embodiments may include a wagering app 14526, which is a program that enables the user to place bets on individual plays in the live event 14502, and displays the audio and video from the live event 14502, along with the available wagers on the mobile device 14524. The wagering app 14526 allows the user to interact with the wagering network 14508 in order to place bets and provide payment/receive funds based on wager outcomes.

FIG. 146 illustrates the current wagers database 14518. The current wagers database 14518 stores data about wagers placed by bettors during the live event 14502 and may include any of a user ID, wager amount, odds, and outcome. The user ID identifying the user of a play by play wagering network who placed the wager, a wager amount is a monetary value wagered by the user, the odds are the multiple by which the wager amount will be increased to calculate a payout if the wager is won. A wager is won if the outcome, the result of a play, occurs. The current wagers database 14518 is populated by the base wagering module 14520 and is used by the base wagering module 14520 and the odds balancing module 14522 to determine the presence of a wagering imbalance and further used by the odds balancing module 14522 to balance the total payouts of all possible outcomes. In an embodiment, wagers are placed on the next play of an American football game and the outcomes upon which wagers are placed are whether or not a first down results from the next play. The total payouts of a first down occurring is $2,000 and the total payouts of a first down not occurring is $10,000 resulting in an exposure to a wagering network 108 of $8,000 or 5/1. The base wagering module 14520 determines the presence of an imbalanced wager market if the exposure to the wagering network 108 exceeds a threshold value, such as 3/1, and the odds balancing module 14522 further incentivizes additional wagers on the first down outcome to balance the exposure to the wagering network 14508.

FIG. 147 illustrates the base wagering module 14520. The process begins with a user logging into the wagering network 14508 at step 14702 via a user interface by entering a username and a password. In an embodiment the username is an email address and the password is a combination of alphanumeric characters. At step 14704 the base wagering module 14520 retrieves the current odds for available wagers from the odds database 14516. At step 14706 the base wagering module 14520 Displays available wagers to a user via a mobile device 14524. The available wagers may include a win condition, such as the offensive team in a football game completing a pass for a first down, and odds, such as 5/1 and can be selected by a user. At step 14708 the base wagering module 14520 receives a wager at from a user via the wagering app 14526 on the mobile device 14524. The wager may include a wager amount such as $50, a win condition, upon which a payout is made according to the odds, and odds, such as 5/1, in which case the user will receive a payout of five times their wager if the win condition is met during the play. At step 14710 the base wagering module 14520 saves the wager to the current wagers database 14518. At step 14712 the base wagering module 14520 retrieves updated odds for available wagers from the odds database 14516. The updated odds may be different than the initial odds. In an embodiment, the initial odds being 1/5 that the next play during an American football team will result in pass for a first down and the updated odds being 1/6 that the same result would occur. At step 14714 the base wagering module 14520 determines the presence of an imbalanced wager market. A wager market provides an option to place wagers on the outcome of a play during a live event 14502. A wager market is imbalanced when the wagering network's 14508 exposure of one outcome exceeds a threshold. In an embodiment, a wager market offering the options to wager that the next play during an American football game will result in a first down at odds of 5/1 or a first down will not occur at odds of 2/1. Wagers totaling $200 are placed on the next play resulting in a first down and wagers totaling $5000 are placed on the next play not resulting in a first down, and the resulting total payout is $1000 if a first down occurs and $10,000 if a first down does not occur resulting in an exposure to the wagering network 14508 of $9000 if the outcome is not a first down which can alternatively be represented by a ratio of 10 to 1. The ratio of 10 to 1 exceeds a threshold of 5 to 1 as defined by an administrator of the wagering network 14508 and indicates an imbalanced wager market. The threshold may alternatively be determined algorithmically or may be an absolute value representing the exposure instead of relative. In further embodiments, a wagering market may have more than two possible outcomes. At step 14716 the base wagering module prompts the odds balancing module 14522 when the presence of an imbalanced wager market has been determined. The odds balancing module 14522 queries the current wagers database 14518 for current wagers and calculates the wagering network's 14508 exposure for each outcome. Further, the base wagering module 14520 identifies the greatest exposure to the wagering network 14508. The base wagering module identifies a user who wagered on the outcome with the lowest exposure and retrieving updated odds from the odds database 14516. If the updated odds are different than the odds when the user placed the wager, the base wagering module 14520 displays an offer to the user to increase their wager such that the total wager, including the original wager amount, will be wagered at the updated odds. The odds balancing module 14522 further determines whether an imbalance still exists and returns to the base wagering module 14520 when an imbalance no longer exists. At step 14718 the base wagering module 14520 compares the results of the play outcome to the outcome wagered upon by polling the sensors 14504. In an embodiment, the wager win condition may be an American football team completing a pass for a first down and the actual result may be an American football team running for a gain of three yards. The base wagering module 14520 further determines that the wager was won if the play outcome and the outcome wagered upon are the same. Alternatively, the base wagering module 14520 determines that the wager was lost if the play outcome and the outcome wagered upon are different. At step 14720 the base wagering module 14520 adjusts the account balance of the user in the user database 14510 based on the result of the wager. If the wager is won, then the base wagering module 14520 increases the account balance in an amount equal to the payout. The payout is determined based upon the odds accepted when the user placed the wager. In an embodiment, the odds are 5/1 and the wager amount is $50, so the payout would be $250. If the wager amount was not debited from the account balance prior to play completion, then adjust the account balance by the difference between the wager amount and the payout. Similarly, if the wager was lost and the wager amount was not previously debited from the account balance, reduce the account balance by the wager amount. At step 14722 the base wagering module polls the sensors 14504 for whether the live event 14502 is complete. If the live event is not complete, the base wagering module 14520 returns to step 14704. The base wagering module 14520 ends the program at step 14724 if the live event 14502 is complete.

FIG. 148 illustrates the odds balancing module 14522. The process begins with receiving a prompt at step 14802 from the base wagering module 14520 that a wager market is imbalanced. The wager market is imbalanced when the exposure of an outcome exceeds a threshold. At step 14804 the odds balancing module 14522 queries the current wagers database 14518 for all wagers placed on a play during a live sporting event 14502. The wagers include a wager amount, odds and an outcome or win condition. In an embodiment, the play is the next play in an American football game and the outcomes or possible win conditions include a first down occurring or a first down not occurring. Additional outcomes may include the success of the play action such as a completed pass for a first down or alternatively an interception by the opposing team. Further outcomes may include a field goal attempt and whether it was successful or a touchdown. At step 14806 the odds balancing module 14522 calculates the total payouts for each outcome by first multiplying each wager amount by the corresponding odds to calculate a single payout, and further summing all payouts with a matching outcome or win condition. In an embodiment, an outcome is a run for a first down and the outcome has three wagers placed on that outcome as the win condition in amounts of $50, $100 and $200, each at odds of 2/1. The resulting payouts would be $100, $200 and $400 respectively resulting in total payouts of $700 for the outcome of a run for a first down. Further the odds balancing module 14522 calculates the total payouts for each additional outcome which received at least one wager. At step 14808 the odds balancing module 14522 determines the wagering network's 14508 largest exposure from a wager market. The largest exposure is the difference between the largest total payouts and the total payouts of all other outcomes. An exposure may be represented as an absolute amount or a ratio representing the relative exposure from one outcome to all other outcomes. In an embodiment, a wager market including two possible outcomes, that a first down will occur on the next play of an American football game or a first down will not occur. The wager network 14508 receiving $200 in wagers at odds of 5/1 that a first down will occur with a total potential payout of $1000 and $5000 in wagers at odds of 2/1 that a first down will not occur with a total potential payout of $10,000. The exposure equal to $10,000 minus $1000 or $9000 or alternatively being represented as 10 to 1 as the exposure represents ten times the losses for the wagering network 14508 compared to the alternative outcomes. At step 14810 the odds balancing module 14522 retrieves updated odds by querying the odds database 14516 for the current odds for the outcome with the least total payouts. At step 14812 the odds balancing module 14522 compares the updated odds to the current wager of a user from the current wagers database 14518. In an embodiment the updated odds being 5/1 and a user Joc Smith having placed a current wager of $100 at 3/1 odds and determining that the updated odds are different than the user's current wager. At step 14814 the odds balancing module 14522 displays an offer to a user to increase their current wager amount at improved odds such that the improved odds would yield a higher payout than the odds at which the current wager was placed. The offer further provides an opportunity for the user to change the odds of the current wager to the improved odds if the user accepts the offer to increase the wager amount. In an embodiment, user Joe Smith has a current wager of $100 at 3/1 odds that the outcome of the next play in an American football play is that the quarterback will be sacked and is offered to increase his wager by $50 to a total wager amount of $150 at 5/1 odds. At step 14816 the odds balancing module 14522 checks whether the offer was accepted by the user. If the offer was accepted, the odds balancing module 14522 proceeds to step 14818, and if the offer was not accepted, returns to the base wagering module 14520. At step 14818 the odds balancing module 14522 checks whether the wager market is still imbalanced by determining the wagering network's exposure and comparing the exposure to a threshold. In an embodiment, a user Joc Smith places an initial wager for $50 at 5/1 odds that the next play of an American football team will result in a first down and upon being offered improved odds of 6/1, increases the initial wager from $50 to $100, thus replacing the initial wager of $50 at 5/1 odds which would have had a potential payout of $250 with a new wager of $100 at 6/1 odds which would have a potential payout of $600 increasing the total payouts for a first down occurring by the difference, or $350. If the original amount of wagers placed on a first down occurring was $200 at odds of 5/1, the original total payout would have been $1000. Increased by the $350 as a result of the increased wager by user Joe Smith, the new total payout for a first down occurring is $1350. If the amount of wagers placed on a first down not occurring does not change from an original amount of $5000 at odds of 2/1, the total payout would remain the same and the new exposure would be $8650 or 10 to 1.35. If the exposure threshold set by an administrator of the wagering network 108 is set at 5 to 1, the exposure of 10 to 1.35 still exceeds the threshold and the wager market is still imbalanced. In an alternate embodiment, the new exposure does not exceed the threshold and the wager market is no longer imbalanced. At step 14820 the odds balancing module 14522 returns to the base wagering module 14520.

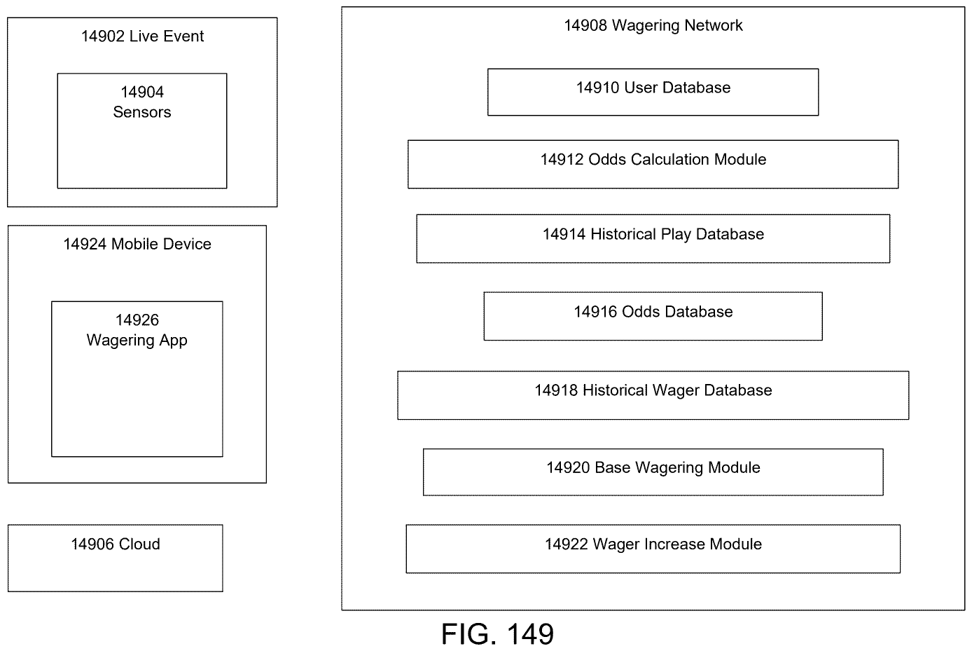

FIG. 149 illustrates a system for an incremental wager method, according to an embodiment.

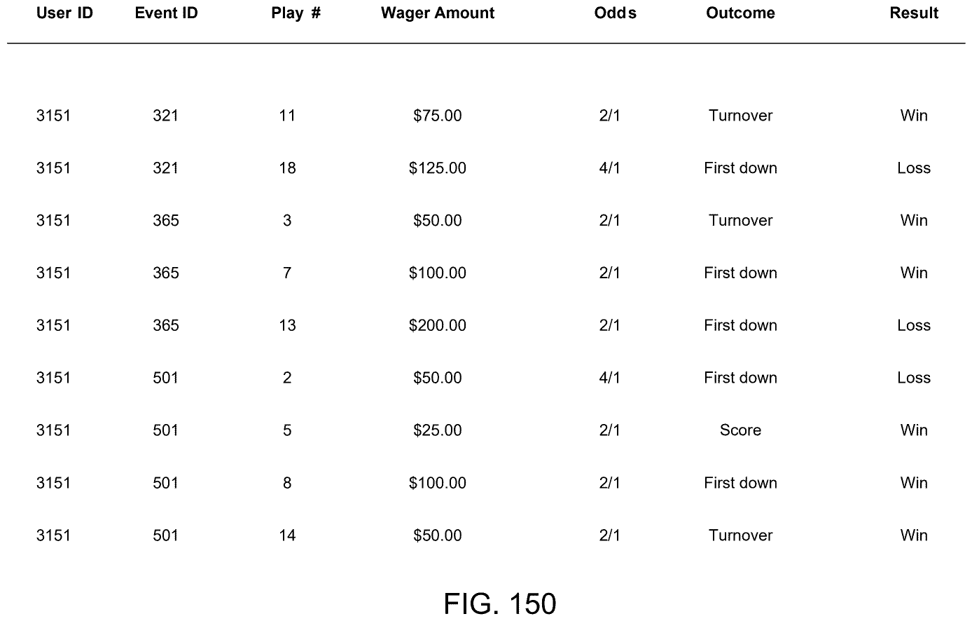

FIG. 150 illustrates a historical wager database, according to an embodiment.

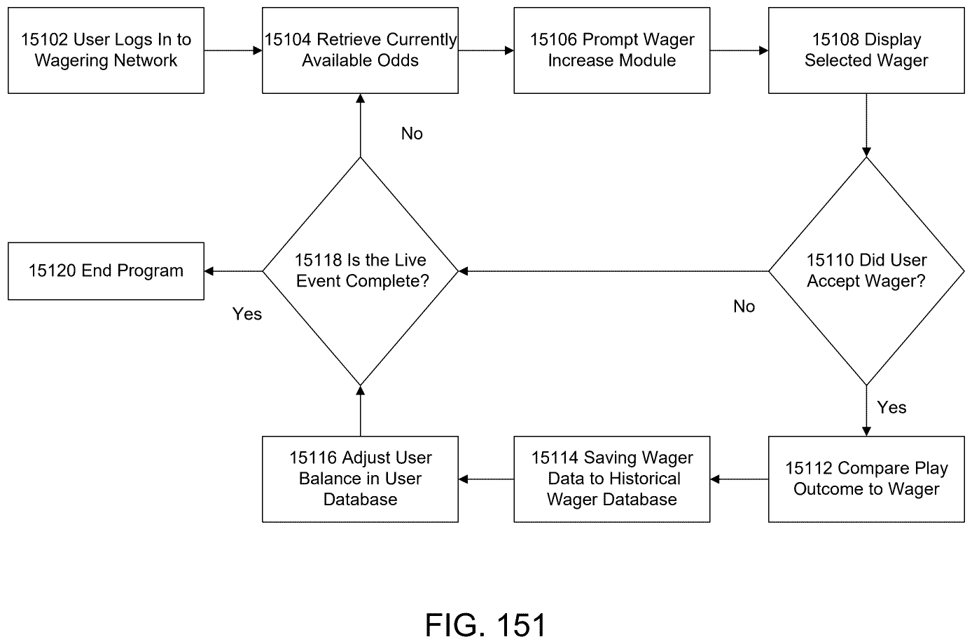

FIG. 151 illustrates a base wagering module, according to an embodiment.

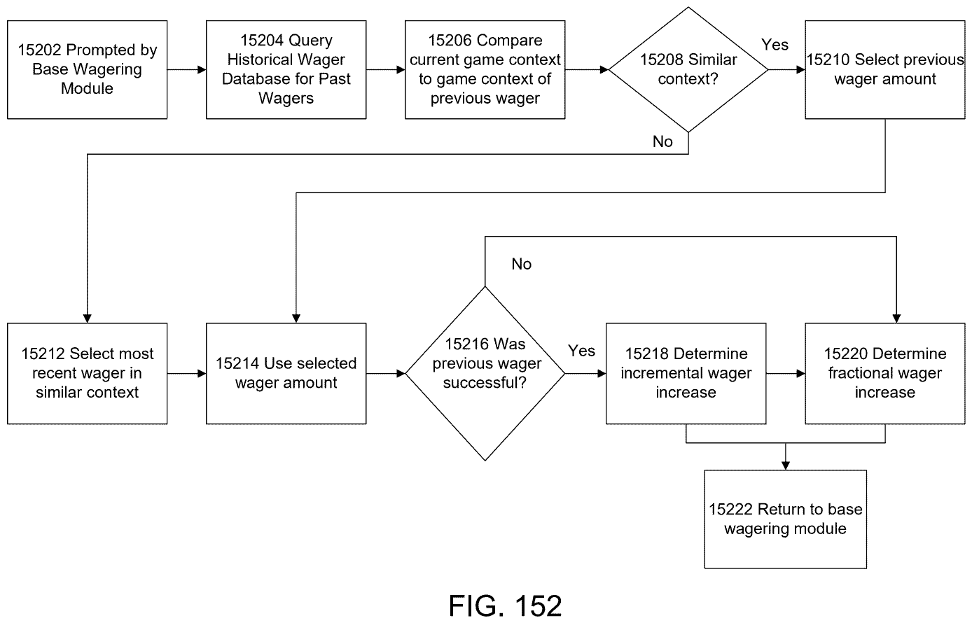

FIG. 152 illustrates a wager increase module, according to an embodiment.

FIG. 149 is a system for an incremental wager method. This system includes a live event 14902, for example a sporting event such as a football game, basketball game, baseball game, hockey game, tennis match, golf tournament, eSports or digital game, etc. The live event 14902 will include some number of actions or plays, upon which a user or customer can place a bet or wager, typically through an entity called a sportsbook. There are numerous types of wagers the user can make, including, a straight bet, a money line bet, a bet with a point spread or line that user's team would need to cover, if the result of the game was the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets, that are added games, that often allow the user to customize their betting, by changing the odds and payouts they receive on a wager. Certain sportsbooks will allow the user to buy points, to move the point spread off of the opening line, this will increase the price of the bet, sometimes by increasing the juice, vig, or hold that the sportsbook takes. Another type of wager the user can make is an over/under, in which the user bets over or under a total for the live event, such as the score of American football or the run line in baseball, or a series of action in the live event 14902. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a user to bet on both sides at different point spreads in order to middle and win both bets. Sportsbooks will often offer bets on portions of games, such as first half bets and half-time bets. Additionally, the sportsbook can offer futures bets on live events in the future. Sportsbooks need to offer payment processing services in order to cash out customers. This can be done at kiosks at the live event 14902 or at another location.

Further, embodiments may include a plurality of sensors 14904 that may be used such as motion sensors, temperature sensors, humidity sensors, cameras such as an RGB-D Camera which is a digital camera capturing color (RGB) and depth information for every pixel in an image, microphones, a radiofrequency receiver, a thermal imager, a radar device, a lidar device, an ultrasound device, a speaker, wearable devices etc. Also, the plurality of sensors 14904 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball.

Further, embodiments may include a cloud 14906 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, such as over the Internet and relies on sharing of resources to achieve coherence and economies of scale, like a public utility, while third-party clouds enable organizations to focus on their core businesses instead of expending resources on computer infrastructure and maintenance. The cloud 14906 may be communicatively coupled to a wagering network 14908 which may perform real time analysis on the type of play and the result of the play. The cloud 14906 may also be synchronized with game situational data, such as the time of the game, the score, location on the field, weather conditions, and the like which may affect the choice of play utilized. For example, in other exemplary embodiments, the cloud may not receive data gathered from sensors and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein.

Further, embodiments may include the wagering network 14908 which may perform real time analysis on the type of play and the result of a play or action. The wagering network 14908 (or cloud 14906) may also be synchronized with game situational data, such as the time of the game, the score, location on the field, weather conditions, and the like which may affect the choice of play utilized. For example, in other exemplary embodiments, a wagering network 14908 may not receive data gathered from sensors and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 14908 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may utilize a user database 14910 which contains data relevant to all users of the system, which may include, a user ID, a device identifier, a paired device identifier, wagering history, and wallet information for each user.

Further, embodiments may include an odds calculation module 14912 which utilizes historical play data to calculate odds for in-play wagers.

Further, embodiments may include a historical play database 14914, that contains play data for the type of sport being played in the Live Sporting Event 14902. For example, in American Football, for optimal odds calculation, the historical play data may include meta data about the historical plays, such as time, location, weather, previous plays, opponent, physiological data, etc.

Further, embodiments may utilize an odds database 14916 that contains the odds calculated by the odds calculation module 14912, and the multipliers for distance and path deviation, and is used for reference by a base wagering module 14920 and to take bets from the user through a user interface and calculate the payouts to the user.

Further, embodiments may utilize a historical wager database 14918 that contains wagers from the live event 14902. Wagers may include a wager amount, odds, and an outcome such that a payout in the amount of the wager amount multiplied by the odds will be paid to a user if the outcome wagered on occurs, otherwise the wager amount being lost.

Further, embodiments may include the base wagering module 14920 which allows a user to log in to a play by play wagering app 14926. The base wagering module 14920 further retrieves odds from the odds database 14916 and displays wagers to a user, and receives a selected wager from the user. The base wagering module 14920 further prompts a wager multiplier module 14922 which determines a multiplier by which to increase the wager amount selected by the user. The base wagering module 14920 displays a proposed wager increase to the user and receives a selection from the user to either keep the wager amount unchanged or increase the wager amount as proposed by the wager multiplier module 14922, or alternatively increase the wager amount by an incremental amount less than or greater than the wager amount proposed by the wager multiplier module 14922.

Further, embodiments may include a wager multiplier module 14922 which is prompted by the base wagering module 14920 when a wager is received from a user. The wager multiplier module 14922 queries the historical wager database 14918 and determines whether the user's recent wagers have been successful. The wager multiplier module 14922 further determines an incremental amount by which to propose increasing the user's current wager and returns the proposed increase to the base wagering module 14920.

Further, embodiments may include a mobile device 14924 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allow for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 14924 could be an optional component and would be utilized in a situation in which a paired wearable device is utilizing the mobile device 14924 as additional memory or computing power or connection to the internet.

Further, embodiments may include the wagering app 14926, which is a program that enables the user to place bets on individual plays in the live event 14902, and display audio and video from the live event 14902, along with any available wagers on the mobile device 14926. The wagering app 14926 allows the user to interact with the wagering network 14908 in order to place bets and provide payment/receive funds based on wager outcomes.

FIG. 150 illustrates the historical wager database 14918. The historical wager database 14918 stores data about wagers placed by users during the live event 14902 including prior events. The data may info such as any of a user ID, wager amount, odds and outcome. The user ID identifying the user of the wagering network 14908 who placed the wager, a wager amount is a monetary value wagered by the user, the odds are the multiple by which the wager amount will be increased to calculate a payout if the wager is won. A wager is won if the outcome, the result of a play, occurs, else the wager is lost. The historical wager database 14918 is populated by the base wagering module 14920 and is used by the wager increase module 14922 to determine a wager increment amount as a multiple of a user's most recent wager if the user's recent wagers have been successful. Alternatively, the wager increase module increases the user's most recent wager as a fractional amount if the user's recent wagers have been unsuccessful. In an embodiment, a user Joe Smith's previous wager was $50 at odds of 2/1 that the next play during an American football team would result in a turnover. If the outcome is a punt resulting in a change of possession of the ball then user Joe Smith wins the wager. Since the previous wager was successful, the wager amount for the next wager is increased from $50 to $100.

FIG. 151 illustrates the base wagering module 14920. The process begins with a user logging into the wagering network 14908 at step 15102 via a user interface by entering a username and a password. In an embodiment, the username is an email address, and the password is a combination of alphanumeric characters. The base wagering module 14920 retrieves the current odds at step 15104 for available wagers from an odds database 14916. The base wagering module 14920 prompts the wager increase module 14922 at step 15106 with retrieved odds for available wagers. The wager increase module 14922 queries the historical wager database 14918 for wagers previously placed by a user, ranking the wagers by how frequently they have been wagered upon by the user and selecting a wager that the user is likely to accept from the available wagers at the current odds based upon the user's wagering history. The wager increase module 14922 further determines an amount by which to increase the user's most recent wager amount based on the user's recent successful or unsuccessful wagers and returns the selected wager and wager amount to the base wagering module 14920. The base wagering module 14920 displays, at step 15108, the selected wager and wager amount determined by the wager increase module 14922. The selected wager including a win condition and odds and the wager amount being a multiple of a previous wager placed by the user. In an embodiment, the wager includes a win condition, that the next play during an American football game will result in a first down, odds of 5/1 and a wager amount of $100, increased from the previous wager by an amount of $50 due to the user Joc Smith winning the previous wager. The base wagering module 14920 receives, at step 15110, whether the user accepted or rejected the wager. In an embodiment, the user accepting the wager by tapping a confirmation button of the wagering app 14926 displayed on the mobile device 14924. In an alternate embodiment, the user declines the wager by selecting an option declining the wager via the wagering app 14926. Alternately, the user may choose to modify the wager such as by increasing or decreasing the wager amount. The user may alternatively decline the wager by failing to take any action and allowing the wager to timeout, such as with the passing of a specific amount of time or the close of betting for the play for which the wager was offered. If the user declined the wager, the base wagering module 14920 returns to step 15106 and prompts the wager increase module 14922 for another wager. The base wagering module 14920 compares, at step 15112, the results of the play outcome to the outcome wagered upon by polling the plurality of sensors 14904. The base wagering module 14920 determines that the wager was won if the play outcome and the outcome wagered upon are the same. Alternatively, it determines that the wager was lost if the play outcome and the outcome wagered upon are different. In an embodiment, the wager win condition may be the next play during an American football game resulting in a first down and the actual result may be an incomplete pass resulting in a second down in which case the wager is lost. The base wagering module 14920 saves wager data at step 15114 to the historical wager database 14918. The wager data may include wager amount, odds, win condition and the outcome. The wager data may further include the result of the wager, such as whether the wager was won or lost. The data may additionally include the payout or loss resulting from the wager. The base wagering module 14920 adjusts, at step 15116, the account balance of the user in the user database 14910 based on the results of the wager. If the wager is won, then increase the account balance in an amount equal to the payout. The payout is determined based upon the odds accepted when the user placed the wager. In an embodiment, the odds are 5/1 and the wager amount is $50, so the payout would be $250. If the wager amount was not debited from the account balance prior to play completion, then adjust the account balance by the difference between the wager amount and the payout. Similarly, if the wager was lost and the wager amount was not previously debited form the account balance, reduce the account balance by the wager amount. The base wagering module 14920 polls the sensors 14904 at step 15118 for whether the live event 14902 is complete. If the live event is not complete, the base wagering module 14920 returns to step 15104 and repeats the steps. The base wagering module 14920 ends the program at step 15120 if the live event 14902 is complete.

FIG. 152 illustrates the wager increase module 14922. The process begins with the wager increase module 14922 receiving a prompt at step 15202 from the base wagering module 14920 which may include available wagers and odds which may be placed on the next play during the live event 14902. Additionally, the wager increase module 14922 receives contextual information about the current state of the live event 14902 from the sensors 14904. In an embodiment the live event 14902 is an American football game, and the contextual information may include info such as the current down, such as first, second third or fourth, and the number of yards to a first down, time left in the game, the score, the teams involved, the players on the field, the formation of the offense and defense, etc. the wager increase module 14922 Queries at step 15204 the historical wager database 14918 for wagers previously placed by the user. The wagers may include a wager amount, odds, a win condition and the context of the live event 14902 when the wagers, result of the wager, etc. In this example, user Joc Smith previously wagered $50 that the New England Patriots would convert a second and 5 for a first down with five minutes to go in the second quarter. The outcome of the wager was a run for 12 yards resulting in a first down, therefore the user Joe Smith won the wager. the wager increase module 14922 compares, at step 15206, the current context of the live event 14902 to the context of the live event 14902 when the user placed their most recent wager. In an exemplary embodiment, the user Joe Smith wagered $50 that the 2nd down and 5 yards to go for the New England Patriots with five minutes to go in the second quarter. The play resulted in a first down, making the new game context first and 10. The level of similarity between the plays can be based on a number of factors. In some embodiments the plays can have a similarity score that takes into account a number of context elements of the live event 14902. The wager increase module 14922 determines, at step 15208, if the current context of the live event 14902 is above a threshold of similarity to the context of the live event 14902 for the user's most recent wager. In an exemplary embodiment the threshold of similarity is assigned by the wagering network 108 administrator and is defined as a similar down and within 3 yards to go for a first down. A similar down being defined as a kicking versus a non-kicking down. A 1st, 2nd, or 3rd down being a non-kicking down, and 4th down being a kicking down. The purpose of this distinction is to prevent the system from populating the wager amount on a 3rd down conversion play on a punting play when the 3rd down was not converted as this is a wager the user is unlikely to make. In this example, a 2nd down and 5 would be above the threshold of similarity to 1st down and 10. If the user's previous wager was placed on a play inside of the live event 14902 that was above the similarity threshold, the wager increase module 14922 selects, at step 15210, the wager amount from the user's previous wager. In an exemplary embodiment, the context of the user Joe Smith's most recent wager, $50 on the conversion of a 2nd down and 5, is above the similarity threshold, of also being on a non-kicking down, to the current context of the live event 102, a 1st and 10 play. The wager amount, $50, is selected at step 15210. If the user's previous wager was on a play not above the similarity threshold, most recent wager placed by the user that is above the similarity threshold is selected at step 15212 from the user's previous wagers in the historical wager database 14918. In another embodiment in which the position on field is part of the similarity threshold, the user Joe Smith's most recent wager on 2nd and 4 from the 40 yard line, may not be above the similarity threshold because the next play is from the 1 yard line. In that example, the user Joe Smith's most recent wager on a 1st and goal from the 1 yard line may be selected at step 15212. The wager amount selected at either step 15210 or 15212 is used at step 15214 as the basis for the proposed wager amount. The wager increase module 14922 determines at step 15216 if the user's most recent wager was successful. The success or failure of the user's most recent wager is used to determine if the amount of the wager selected at step 15214 should be increased by an increment, i.e. double or triple the amount, or by a fraction, i.e. by 10% or 50%. If the user's won their most recent wager the wager increase module 14922 determines at step 15218 the incremental wager increase to propose to the user for their next available wager. In an embodiment that increment is always to double the wager amount of the wager the user just won. This would result in a wager amount of $100 being proposed to the user Joe Smith's on his next wagering opportunity. The $100 being his most recent wager of $50 being doubled. In other embodiments the increase in the wager can vary contextually. For example, the user's wager history may be examined to determine the maximum amount the user has wagered on a similar play and propose that amount. Alternatively, the user's average or most frequent wager amount on similar plays could be used as the base and/or increment for increasing the wager amount proposed to the user on their next wagering opportunity. Additionally, the user may have the option to “let it ride” and wager their winnings on the previous play or combination of plays on their next wagering opportunity. If the user lost their most recent wager the wager increase module 14922 determines at step 15220 the fractional wager increase to propose to the user for their next available wager. In an embodiment that increment is always 50% more than the wager amount of the wager the user just lost. This would result in a wager amount of $75 being proposed to the user Joe Smith's on his next wagering opportunity. The $75 being his most recent wager of $50 plus 50%. In other embodiments the increase in the wager can vary contextually. For example, the user's wager history may be examined to determine that they have lost multiple consecutive wagers and adjust the wager increase by more. Alternatively, the frequency and context in which the user selects a proposed wager can be used to determine the wager amount proposed. In an exemplary embodiment, a user may elect to wager less when larger increases in their wager amount are proposed and the system would decrease the amount their next proposed wager amount. the wager increase module 14922 returns, at step 15220, a wager proposal to the base wagering module 14920.

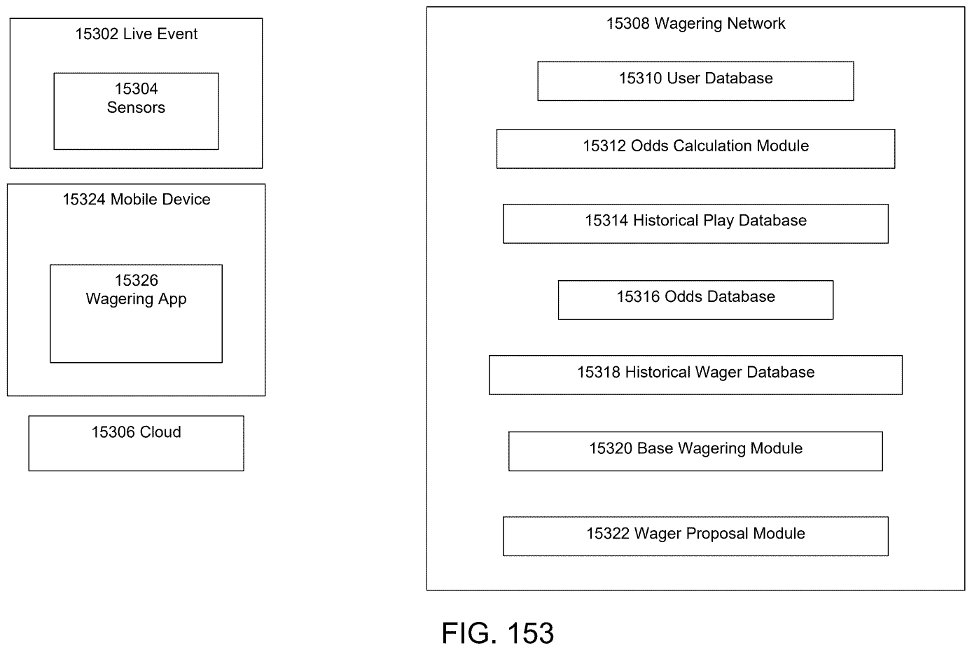

FIG. 153 illustrates a system for an automatic wager method, according to an embodiment.

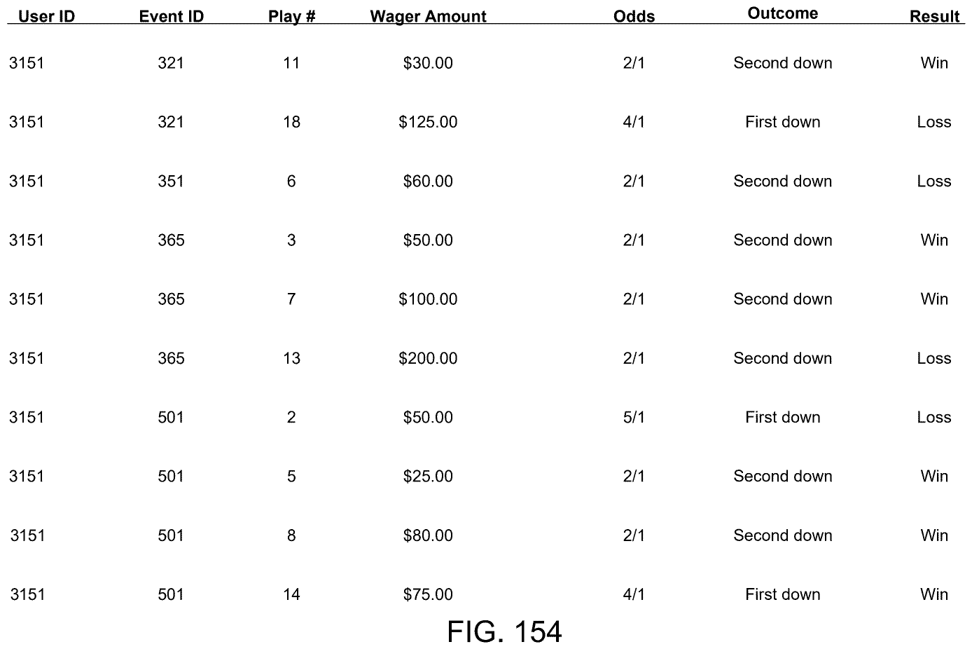

FIG. 154 illustrates a historical wager database, according to an embodiment.

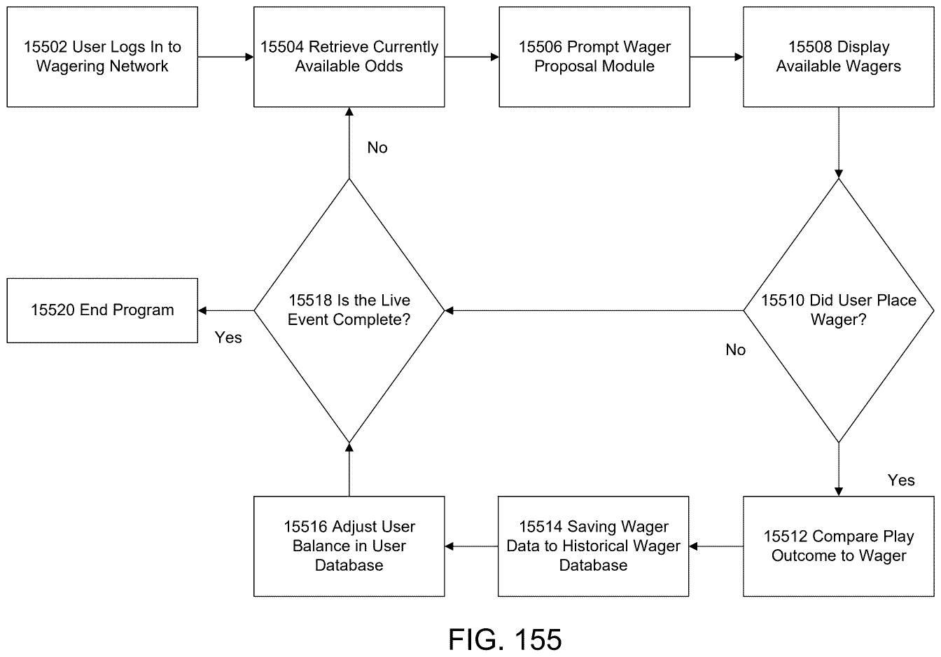

FIG. 155 illustrates a base wagering module, according to an embodiment.

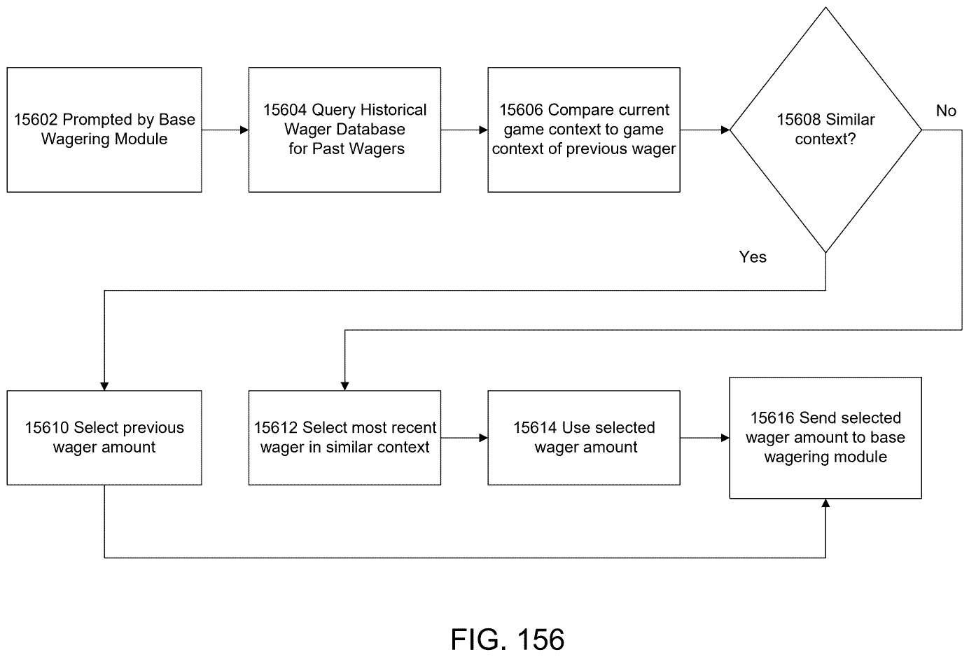

FIG. 156 illustrates a wager proposal module, according to an embodiment.

FIG. 153 is a system for an automatic wager method. This system comprises of a live event 15302, for example a sporting event such as a football game, basketball game, baseball game, hockey game, tennis match, golf tournament, eSports or digital game, etc. The live event 15302 will include some number of actions or plays, upon which a user or customer can place a bet or wager, typically through an entity called a sportsbook. There are numerous types of wagers the user can make, including, a straight bet, a money line bet, a bet with a point spread or line that user's team would need to cover, if the result of the game was the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets, that are added games, that often allow the user to customize their betting, by changing the odds and payouts they receive on a wager. Certain sportsbooks will allow the user to buy points, to move the point spread off of the opening line, this will increase the price of the bet, sometimes by increasing the juice, vig, or hold that the sportsbook takes. Another type of wager the user can make is an over/under, in which the user bets over or under a total for the live event, such as the score of American football or the run line in baseball, or a series of action in the live event. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a user to bet on both sides at different point spreads in order to middle and win both bets. Sportsbooks will often offer bets on portions of games, such as first half bets and half-time bets. Additionally, the sportsbook can offer futures bets on live events in the future. Sportsbooks need to offer payment processing services in order to cash out customers. This can be done at kiosks at the live event 15302 or at another location.

Further, embodiments may include a plurality of sensors 15304 that may be used such as motion sensors, temperature sensors, humidity sensors, cameras such as an RGB-D Camera which is a digital camera capturing color (RGB) and depth information for every pixel in an image, microphones, a radiofrequency receiver, a thermal imager, a radar device, a lidar device, an ultrasound device, a speaker, wearable devices etc. Also, the plurality of sensors 15304 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball.

Further, embodiments may include a cloud 15306 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, such as over Internet and relies on sharing of resources to achieve coherence and economies of scale, like a public utility, while third-party clouds enable organizations to focus on their core businesses instead of expending resources on computer infrastructure and maintenance. The cloud 15306 may be communicatively coupled to wagering network 15308 which may perform real time analysis on the type of play and the result of the play. The cloud 15306 may also be synchronized with game situational data, such as the time of the game, the score, location on the field, weather conditions, and the like which may affect the choice of play utilized. For example, in other exemplary embodiments, the cloud 15306 may not receive data gathered from sensors and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein.

Further, embodiments may include the wagering network 15308 which may perform real time analysis on the type of play and the result of a play or action. The wagering network 15308 (or cloud 15306) may also be synchronized with game situational data, such as the time of the game, the score, location on the field, weather conditions, and the like which may affect the choice of play utilized. For example, in other exemplary embodiments, the wagering network 15308 may not receive data gathered from sensors and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 15308 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may utilize a user database 15310 which contains data relevant to all users of the system, which may include, a user ID, a device identifier, a paired device identifier, wagering history, and wallet information for each user.

Further, embodiments may include an odds calculation module 15312 which utilizes historical play data to calculate odds for in-play wagers.

Further, embodiments may include a historical play database 15314, that contains play data for the type of sport being played in a Live Sporting Event 15302. For example, in American Football, for optimal odds calculation, the historical play data should include meta data about the historical plays, such as time, location, weather, previous plays, opponent, physiological data, etc.

Further, embodiments may utilize an odds database 15316 that contains the odds calculated by the odds calculation module 15312, and the multipliers for distance and path deviation, and is used for reference by a base wagering module 15320 and to take bets from the user through a user interface and calculate the payouts to the user.

Further, embodiments may utilize a historical wager database 15318 that contains wagers from the live event 15302. Wagers may include a wager amount, odds, and an outcome such that a payout in the amount of the wager amount multiplied by the odds will be paid to a user if the outcome wagered on occurs, otherwise the wager amount being lost.

Further, embodiments may include the base wagering module 15320 which allows a user to log in to the wagering network 15308. The base wagering module 15320 further retrieves odds from the odds database 15316 and prompts a wager proposal module 15322 which retrieves a user's wager history including a previous wager amount and sets a wager amount for the currently available wagers and returns the wager amount to the base wagering module 15320. Displaying the available wagers including the wager amount to a user and receiving a wager from a user. Further determining whether the wager was won or lost and adjusting the user's account balance accordingly.

Further, embodiments may include a wager proposal module 15322 which is prompted by the base wagering module 15320 with the currently available wagers. The wager proposal module 15322 queries the historical wager database 15318 for the user's wager history and selecting a wager amount from a previous wager placed by the user to propose as a wager amount to the user for the currently available wagers.

Further, embodiments may include a mobile device 15324 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allows for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 15324 could be an optional component and would be utilized in a situation in which a paired wearable device is utilizing the mobile device 15324 as additional memory or computing power or connection to the internet.

Further, embodiments may include a wagering app 15326, which is a program that enables the user to place bets on individual plays in the live event 15302, and display the audio and video from the live event 15302, along with the available wagers on the mobile device 15326. The wagering app 15326 allows the user to interact with the wagering network 15308 in order to place bets and provide payment/receive funds based on wager outcomes.

FIG. 154 illustrates the historical wager database 15318. The historical wager database 15318 stores data about wagers placed by users during the live event 15302 including prior events. The data may include any of a user ID, wager amount, odds and outcome. The user ID identifying the user of the wagering network 15308 who placed the wager, a wager amount is a monetary value wagered by the user, the odds are the multiple by which the wager amount will be increased to calculate a payout if the wager is won. A wager is won if the outcome, the result of a play, occurs. The historical wager database 15318 is populated by the base wagering module 15320 and is used by the wager proposal module 15322 to determine the conditions of a wager and the wager amount. In an embodiment, the wager proposal module 15322 determines a proposed wager based upon a user's previous wager history as stored in the historical wager database 15318 and determines that the user has previously wagered on the next play in an American football game resulting in a first down and at odds ranging from 3/1 to 6/1 and confirms that the next play in an American football game resulting in a first down is an available wager is among the currently available wagers at odds of 5/1. Further the historical wager database 15318 determines a wager amount by retrieving the previous wager amount placed by the user when the wager was that the next play during an American football game would result in a first down at odds of 5/1, the amount being $50, and thus determines the proposed wager amount to be the same as the previously placed wager with the same win condition at $50.

FIG. 155 illustrates the base wagering module 15320. The process begins with A user logging into the wagering network 15308 at step 15502 via a user interface by entering a username and a password. In an embodiment, the username is an email address, and the password is a combination of alphanumeric characters. The base wagering module 15320 retrieves current odds at step 15504 for available wagers from the odds database 15316. The base wagering module 15320 prompts the wager proposal module 15322 at step 15506 with retrieved odds for available wagers. The wager proposal module 15322 queries the historical wager database 15318 for wagers previously placed by a user and selects a wager amount that the user is likely to accept based upon the user's wager history. The historical wager database 15318 returns the selected wager and currently available wagers to the base wagering module 15320 as a wager proposal. The base wagering module 15320 displays the available wagers at step 15508 including a wager amount and at least one wager option such as odds and a win condition. The wager proposal module 15322 determines the available wagers, such as a win condition and odds and a wager amount which the user is likely to accept based on the user's previous wagering history. In an exemplary embodiment, in an American football game between the New England Patriots and the New York Giants, user Joe Smith is provided the option to wager $50 on the Patriots converting a first and 10 for a first down at odds of 5/1 or alternatively wager $50 on the attempt to convert a first and 10 failing and resulting in a second down at odds of 2/1. The base wagering module 120 receives, at step 15510, a wager for the user from the available wagers. In an exemplary embodiment of an American football game between the New England Patriots and the New York Giants, user Joe Smith wagers $50 on the Patriots converting a first and 10 for a first down at odds of 5/1 with 5 minutes 45 seconds to go in the third quarter. The user may modify the available wager such as by increasing or decreasing the wager amount prior to placing a wager. Alternatively, the user may decline the available wagers by selecting an option declining the available wagers or taking no action and allowing the wager opportunities to timeout such as if the play begins and no new wagers are accepted for the play in progress. If the user declined to place a wager, the base wagering module 15320 advances to step 15518. The base wagering module 15320 compares at step 15512, the results of the play outcome to the outcome wagered upon by polling the plurality of sensors 15304. The base wagering module 15320 determines that the wager was won if the play outcome and the outcome wagered upon are the same. Alternatively, the base wagering module 15320 determines that the wager was lost if the play outcome and the outcome wagered upon are different. In an exemplary embodiment of an American football game between the New England Patriots and the New York Giants, a user Joe Smith having wagered $50 that the Patriots will convert a first and 10 for a first down at odds of 5/1 and the play resulting in an incomplete pass resulting in a second down in which case the wager was lost. The base wagering module 15320 saves wager data at step 15514 to the historical wager database 15318. The wager data can include things such as wager amount, odds, win condition, contextual information about the live event 15302 and the outcome. The wager data may further include the result of the wager, such as whether the wager was won or lost and the payout or loss resulting from the wager. The base wagering module 15320 adjusts, at step 15516, the account balance of the user in the user database 15310 based on the results of the wager. If the wager is won, then the account balance is increased in an amount equal to the payout. The payout is determined based upon the odds accepted when the user placed the wager. In an embodiment, the odds are 5/1 and the wager amount is $50, so the payout would be $250. If the wager amount was not debited from the account balance prior to play completion, then the account balance is adjusted by the difference between the wager amount and the payout. Similarly, if the wager was lost and the wager amount was not previously debited form the account balance, the account balance is reduced by the wager amount. The base wagering module 15320 polls the plurality of sensors 15304 at step 15518 to determine whether the live event 15302 is complete. If the live event 15302 is not complete, The base wagering module 15320 returns to step 15504 and repeats the steps. The base wagering module 15320 ends the program at step 15520 if the live event 15302 is complete.

FIG. 156 illustrates the wager proposal module 15322. The process begins with the wager proposal module 15322 receiving a prompt at step 15602 from the base wagering module 15320 including available wagers and odds which may be placed on the next play during a live event 15302. The wager proposal module 15322 additionally receives contextual information about the current state of the live event 15302 from the plurality of sensors 15304. In an exemplary embodiment the live event 15302 is an American football game, and the contextual information may include any of the current down, such as first, second third or fourth, and the number of yards to a first down, time left in the game, the score, the teams involved, the players on the field, the formation of the offense and defense, etc. The wager proposal module 15322 Queries at step 15604 the historical wager database 15318 for wagers previously placed by the user. The wagers including a wager amount, odds, a win condition and the context of the live event 15302 when the wagers, result of the wager, etc. In this example, user Joc Smith previously wagered $50 that the New England Patriots would convert a second and 5 for a first down with five minutes to go in the second quarter. The outcome of the wager was a run for 12 yards resulting in a first down, therefore the user Joe Smith won the wager. The wager proposal module 15322 compares, at step 15606, the current context of the live event 15302 to the context of the live event 15302 when the user placed their most recent wager. For example, the user Joc Smith wagered $50 that the 2nd down and 5 yards to go for the New England Patriots with five minutes to go in the second quarter. The play resulted in a first down, making the new game context first and 10. The level of similarity between the plays can be based on a number of factors. In some embodiments the plays can have a similarity score that considers a number of context elements of the live event 15302. The wager proposal module 15322 determines at step 15608 if the current context of the live event 15302 above a threshold of similarity to the context of the live event 15302 for the user's most recent wager. In this example the threshold of similarity is assigned by the wagering network 15308 administrator and is defined as a similar down and within 3 yards to go for a first down. A similar down being defined as a kicking versus a non-kicking down. A 1st, 2nd, or 3rd down being a non-kicking down, and 4th down being a kicking down. The purpose of this distinction is to prevent the system from populating the wager amount on a 3rd down conversion play on a punting play when the 3rd down was not converted as this is a wager the user is unlikely to make. In this example, a 2nd down and 5 would be above the threshold of similarity to 1st down and 10. If the user's previous wager was placed on a play inside of the live event 15302 that was above the similarity threshold, select at step 15610, the wager amount from the user's previous wager. In this example, the context of the user Joe Smith's most recent wager, $50 on the conversion of a 2nd down and 5, is above the similarity threshold, of also being on a non-kicking down, to the current context of the live event 15302, a 1st and 10 play. The wager amount, $50, is selected at step 15610. If the user's previous wager was on a play not above the similarity threshold, the most recent wager placed by the user that is above the similarity threshold is selected at step 15612 from the user's previous wagers in the historical wager database 15318. In another embodiment in which the position on field is part of the similarity threshold, the user Joe Smith's most recent wager on 2nd and 4 from the 40 yard line, may not be above the similarity threshold because the next play is from the 1 yard line. In this embodiment, the user Joe Smith's most recent wager on a 1st and goal from the 1 yard line may be selected at step 15612. The wager amount selected at either step 15610 or 15612 is used at step 15614, as the basis for the proposed wager amount. The selected wager amount is then sent at step 15616 to the base wagering module 15320.

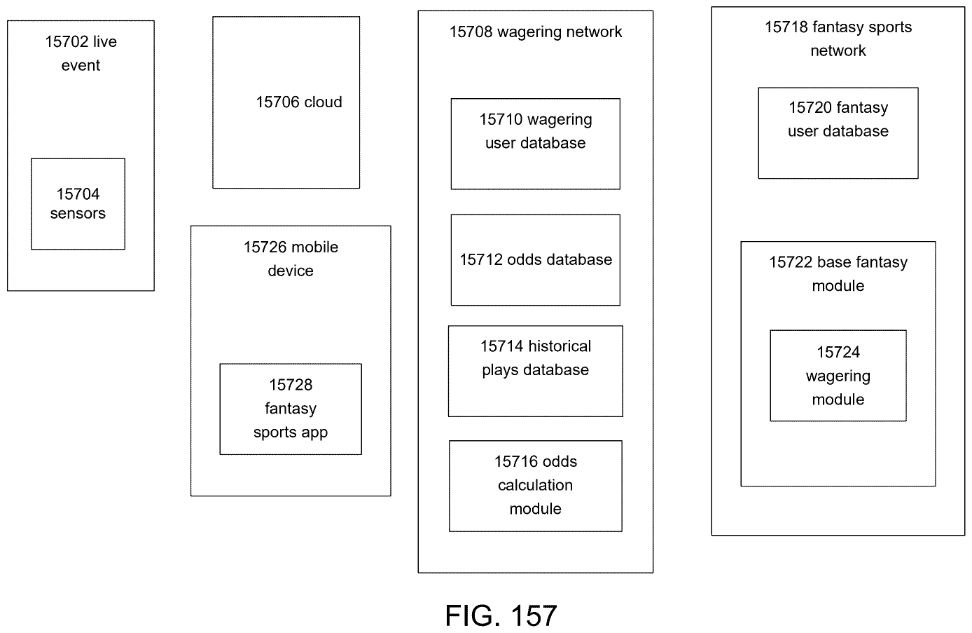

FIG. 157 illustrates a system for in-play wagering through a fantasy sports network, according to an embodiment.

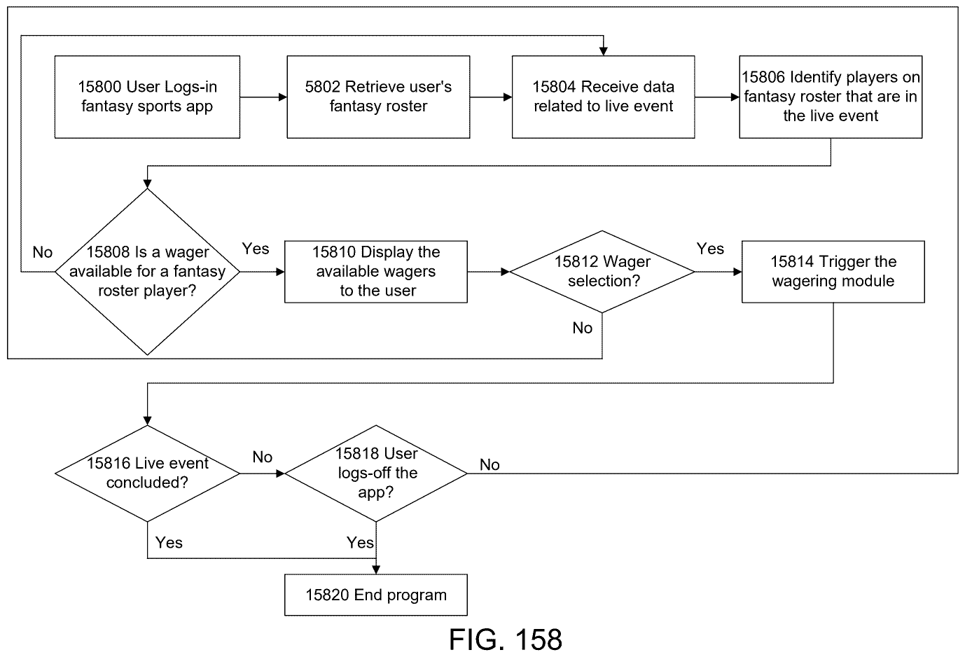

FIG. 158 illustrates a base fantasy module, according to an embodiment.

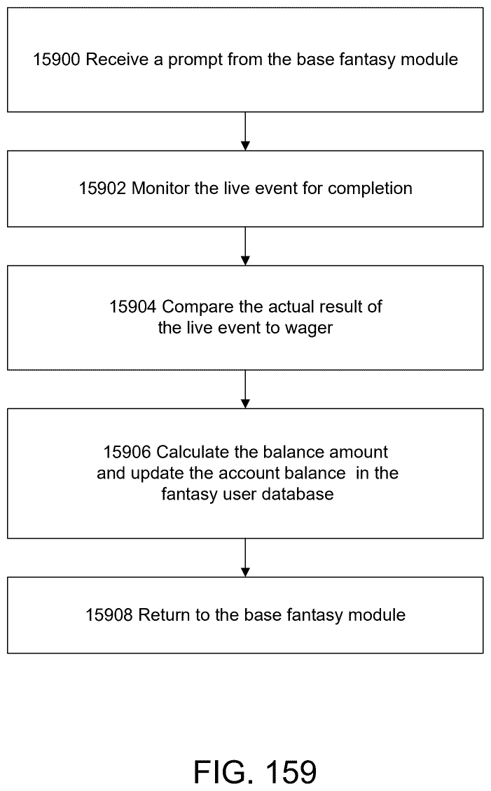

FIG. 159 illustrates a wagering module, according to an embodiment.

FIG. 157 is a system for in-play wagering through a fantasy sports network. This system is comprised of a live event 15702, for example, a sporting event such as an American football game, a basketball game, a hockey game, a tennis match, golf tournament, eSports or digital game, etc. The live event 15702 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round-robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 15702, such as the score of American football or the run line in baseball, or a series of action in the live event 15702. Sportsbooks have a number of bets they can handle, a limit of wagers they can take on either side of a bet before they will move the line or odds off of the opening line. Additionally, there are circumstance, such an injury to an important player such as a listed pitcher, in which a sportsbook, casino or racino will take an available wager off the board. As the line moves there becomes an opportunity for a bettor to bet on both sides at different point spreads to middle and win both bets. Sportsbooks will often offer bets on portions of games, such as first half bets and half-time bets. Additionally, the sportsbook can offer futures bets on live events 15702 in the future. Sportsbooks need to offer payment processing services to cash out customers. This can be done at kiosks at the live event 15702 or another location. For example, considering a live event 15702 being an American football game that is played between the Philadelphia Eagles and the New England Patriots, at Lincoln Financial Field, Philadelphia.

Further, embodiments may include a plurality of sensors 15704 that may be used such as motion sensors, temperature sensors, humidity sensors, cameras such as an RGB-D camera which is a digital camera capturing color (RGB) and depth information for every pixel in an image, microphones, radiofrequency receiver, a thermal imager, a radar device, a LIDAR device, an ultrasound device, a speaker, wearable devices etc. Also, the plurality of sensors 15704 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that collects statistical information through real-time X, Y positioning of players and X, Y, Z positioning of the ball. In the example of American football game, the plurality of sensors 15704 may be used for capturing parameters such as player acceleration, player speed (2 sensors on shoulders of the player and 1 sensor on player's helmet), goal line, and quarterback ball velocity.

Further, embodiments may include a cloud 15706 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable resources and higher-level services that can be rapidly provisioned with minimal management effort, often over internet and relies on sharing of resources to achieve coherence and economics of scale, like a public utility, while third-party clouds enable organizations to focus on their core businesses instead of expending resources on computer infrastructure and maintenance. The cloud 15706 may be communicatively coupled to a wagering network 15708 which may perform real-time analysis on the type of play and the result of the play. The cloud 15706 may also be synchronized with game situational data, such as the time of the game, the score, location on the field, weather conditions, and the like which may affect the choice of play utilized. For example, in other embodiments, the cloud 15706 may not receive data gathered from sensors 15704 and may, instead, receive data from an alternative data feed, such as SportsRadar®. This data may be compiled substantially immediately following the completion of any play and the data from this feed may be compared with a variety of team data and league data based on a variety of elements, including possession, score, time, team, and so forth, as described in various embodiments herein.

Further, embodiments may include a wagering network 15708 which may perform real-time analysis on the type of play and the result of a play or action. The wagering network 15708 (or cloud 15706) may also be synchronized with game situational data, such as the time of the game, the score, location on the field, weather conditions, and the like which may affect the choice of play utilized. For example, in other embodiments, the wagering network 15708 may not receive data gathered from sensors 15704 and may, instead, receive data from an alternative data feed, such as SportsRadar®. This data may be compiled substantially immediately following the completion of any play and the data from this feed may be compared with a variety of team data and league data based on a variety of elements, including possession, score, time, team, and so forth, as described in various embodiments herein. The wagering network 15708 can offer a number of software as a service managed services such as, user interface service, risk management service, compliance, pricing and trading service, IT support of the technology platform, business applications, game configuration, state-based integration, fantasy sports connection, integration to allow the joining of social media, as well as marketing support services that can create engaging promotions to the user. In one embodiment, the wagering network 15708 may facilitate the user with settlement options related to the wager. In another embodiment, the wagering network 15708 may use third party balance settlement apps linked to a fantasy sports software application (or fantasy sports app) 15728, for settlement of the balances of the user. For example, Draftkings® app may use PayPal for settlement of the balances of the user.

Further, embodiments may utilize a wagering user database 15710 which contains data relevant to all users of the wagering network 15708, which may include, a user ID, a device identifier, and wagering history. The wagering user database 15710 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the wagering user database 15710 may contain betting lines and search queries. The wagering user database 15710 may be searched, based on a search criteria received from the user. Each betting line may include a plurality of betting attributes such as at least one of the live event 15702, a team, a player, an amount of wager, etc. The wagering user database 15710 may include information related to all the users involved in the live event 15702. In one example embodiment, the wagering user database 15710 may include information for generating a user authenticity report and a wagering verification report. Further, the wagering user database 15710 may be used to store user statistics like, but not limited to, retention period for a particular user, frequency of wagers placed by a particular user, average amount of wager placed by each user, etc.

Further, embodiments may utilize an odds database 15712 that contains the odds calculated by an odds calculation module 15716. The odds database 15712 stores all the odds and may be used by the fantasy sports network 15718 to facilitate the user with wagering opportunities, through the fantasy sports app 15728. In one embodiment, the type of wagering may depend on the type of game being played.

Further, embodiments may utilize a historical plays database 15714 that contains play data for the type of sport being played in the live event 15702. In one embodiment, for optimal odds calculation, the historical play data should include metadata about the historical plays, such as time of the live event 15702, location, weather, previous plays, opponent, physiological data of the players (including blood pressure, pulse rate, and respiration rate), completed passes by all players, information related to the players such as injuries in the past, touchdowns, player speed, player acceleration, catch probability, information related to trainers of each player, etc. For example, in the American football game, information stored in the historical plays database 15714 may include information related to the previous American football games played by the Philadelphia Eagles such as, but not limited to, the weather condition, i.e. during the match, it was cloudy.

Further, embodiments may include an odds calculation module 15716 which utilizes information from historical plays database 15714 and the information from the sensor feeds 15704 to calculate odds for in-play wagers. The information from the historical plays database 15714 may include data related to the type of the play, the previous information related to players involved in the live event 15702, and results of the previous live events 15702. The odds for each live event 15702, such as in an American football game, a particular player scoring a touchdown, completing a pass, or number of picks, may be calculated based on the information received from the sensor feeds 15704 and the previous information related to the particular player. Further, the odds may be updated based on in-game events (for example, a player completing a pass against a particular opponent team, increases the odds of completing the pass against the same opponent team). The odds may be calculated or adjusted based on statistical information related to the live event 15702 and the statistical information of the players. For example, the odds may be determined based on the historical data such as prior performance information about a player (like percentage of completed passes, average number of touchdowns, picks in a game), and physiological information of player(s) etc., and current i.e. real-time information, such as current confidence level etc. In one embodiment, the type of wagering may depend on the type of game being played. In one embodiment, the odds calculation module 15716 may determine the available wagers to the user. The odds calculation module 15716 may also utilize a probability engine, which assembles all the historical data and real-time data and produces the odds (stored in the odds database 15712) for in-play wagers. Thus, the odds calculation module 15716 information relevant to all the potential outcomes, as available wagers, which facilitates the user with a better knowledge to make certain judgements about the potential performance of players in each live event 15702 and place a calculated wager with a potential return on the wager. For example, in American football game, the odds calculation module 15716 may calculate odds related to the possible outcomes of Alshon Jeffrey (wide receiver) for Philadelphia Eagles against New England Patriots, scoring a touchdown are 4/1 (in moneyline+400), completing a pass are 5/1, and scoring a successful kick are 3/1.

Further, embodiments may include a fantasy sports network 15718 which may perform the real-time analysis of each play related to a fantasy sport, in a fantasy sports app 15728 and the result of a play or action. The fantasy sport may correspond to the live event 15702 i.e. a type of game, played via the internet, where users assemble imaginary or virtual teams of real players of a sport, for example, related to the live event 15702. The virtual teams may compete based on the statistical performance of the player in the live event 15702. Further, the performance of players may be converted into points, that are compiled and totaled according to a fantasy roster selected by the user. The fantasy sports network 15718 may be synchronized with the live event 15702 to track each live event 15702 or the whole season related to the live event 15702. Further, the fantasy sports network 15718 may be synchronized with game situational data, such as the time of the game, the score, location on the field, weather conditions, and the like which may affect the choice of play utilized. Further, the fantasy sports network 15718 may be synchronized with the wagering network 15708. For example, in one embodiment, the fantasy sports network 15718 may receive data gathered related to the players involved in the live event 15702, from the wagering network 15708. This data may be compiled substantially immediately following the completion of any play and the data from this feed may be compared with a variety of team data and league data based on a variety of elements, including possession, score, time, team, and so forth, as described in various exemplary embodiments herein. Further, the fantasy sports network 15718 may include settlement options related to settling the user's wagers upon completion of the live event 15702. In one embodiment, the fantasy sports network 15718 may settle the balances of the user. In another embodiment, the fantasy sports network 15718 may use third party balance settlement apps linked, via the fantasy sports network 15718, to the fantasy sports app 15728. For example, Draftkings® app may use PayPal for settlement of the balances of the user.

Further, embodiments may utilize a fantasy user database 15720 which contains data relevant to all users of the fantasy sports network 15718, which may include, a user's fantasy ID, a device identifier, fantasy wagering history, fantasy rosters created by the user in the fantasy sports app 15728, transaction history of the user, live events participated by the user, various contests of the live event 15702 joined by the user, and fantasy wallet information of the user. For example, a fantasy roster for American football game, created by user Casey Huke, may include Alshon Jeffery, Jalen Hurts, and DeScan Jackson from Philadelphia Eagles in the Draftkings® app. In one embodiment, the user may create multiple fantasy rosters for the live event 15702. The fantasy user database 15720 may also contain a list of user fantasy account records associated with a respective user fantasy ID. For example, a user account record may include information such as user interests, user personal details such as fantasy name of the user, players included in the fantasy roster created by the user, previously played sporting events, highest wager, favorite sporting event, and current user standings and balance corresponding to the user's fantasy ID. In addition, the fantasy user database 15720 may contain betting lines and search queries. The fantasy user database 15720 may be searched based on a search criteria received from the user. The fantasy user database 15720 may include information related to all the users involved in the particular contest of the live event 15702, in which the current user is involved. Further, the fantasy user database 15720 may be used to store user statistics like, but not limited to, retention period for a particular user on the fantasy sports app 15728, contests participated in the fantasy sports app 15728, frequency of wagers placed by a particular user, an average amount of wager placed by each user, type of contests played by the user, etc. Further, the fantasy user database 120 may include wallet information of the user. For example, the wallet information may include a user's fantasy ID, a balance amount corresponding to the user's fantasy ID, third party balance settlement apps liked to the fantasy sports app 15728. In one embodiment, the fantasy user database 15720 may settle balances of the user itself. In another embodiment, the fantasy user database 15720 may use third party balance settlement apps linked, via the fantasy sports network 15718, to the fantasy sports app 15728. For example, Draftkings app may use PayPal for settlement of the balances of the user.

Further, embodiments may include a base fantasy module 15722 that allows the user to place in-play wagers. The base fantasy module 15722 may allow the user to log-in/sign-in to the fantasy sports network 15718 through the fantasy sports app 15728 on the mobile device 15726, during the live event 15702. After logging in to the fantasy sports app 15728, the base fantasy module 15722 may retrieve user's fantasy roster from the fantasy user database 15720. For example, a fantasy roster including Alshon Jeffery, Jalen Hurts, and DeScan Jackson from Philadelphia Eagles in the Draftkings® app, is retrieved from the fantasy user database 15720. Further, the base fantasy module 15722 may receive data related to the live event 15702. For example, the base fantasy module 15722 receives data related to the live event 15702 that Alshon Jeffery is currently playing. Based on the retrieved fantasy roster and the received live event data, the base fantasy module 15722 may identify players on the fantasy roster that are playing in the live event 15702. In one example embodiment, the base fantasy module 15722 may identify players on the fantasy roster that are on offense, or who are otherwise active or playing, in the live event 15702. For example, Alshon Jeffery is a part of the fantasy roster and is active and playing on offense in the live event 15702. Based on the identified players on the fantasy roster that are playing in the live event 15702, the base fantasy module 15722 may determine if a wager is available for the fantasy roster player. In one case, if the wagers are available for the fantasy roster player, then the base fantasy module 15722 may display available wagers to the user. In one embodiment, the available wagers may be displayed to the user on the mobile device 15726. For example, a wager of $100 is available for Alshon Jeffery, for scoring a touchdown with odds of 4/1. Further, the available wager of $100 for Alshon Jeffery, for scoring a touchdown with odds of 4/1, is displayed to the user Casey Huke. Further, the wager may be displayed in various forms such as, but not limiting to, the player with the available wager can be highlighted, all the players on offense can be highlighted (i.e. considering wager is available for players on offense), or the wagers can be displayed on the player's representation on the user's fantasy roster. In another embodiment, due to limited screen space on the mobile device 15726, sub-menus may be displayed on the highlighted player with the available wagers or the highlighted players on offense, to allow for more wagers to be displayed. In another case, if the wager is not available for the fantasy roster player, then the base fantasy module 15722 may continue receiving data related to the live event 15702. Further, the base fantasy module 15722 may check for wager selection. In one case, if the wager is selected by a user, then the base fantasy module 15722 may trigger a wagering module 15724. For example, the user selects the wager of $100 to be placed on Alshon Jeffery for scoring a touchdown. In another case, if no wager is selected by the user, then the base fantasy module 15722 may continue receiving the data related to the live event 15702. Thereafter, the base fantasy module 15722 may constantly monitor if the live event 15702 is concluded or if the user logs-off from the fantasy sports app 15728, during the live event 15702.

Further, embodiments may include a wagering module 15724 which is triggered when a wager is placed by the user in the live event 15702, via the base fantasy module 15722. After receiving the prompt from the base fantasy module 15722, the wagering module 15724 may constantly monitor the live event 15702 for completion and thereby obtain a result of the live event 15702. In one case, when the live event 15702 is concluded, then the wagering module 15724 may proceed to compare the result of the live event 15702 with the wager placed by the user. In another case, when the live event 15702 is not concluded, then the wagering module 15724 may continue monitoring the live event 15702 for completion. Further, the wagering module 15724 may compare the result of the live event 15702 with the wagers placed by the user, to determine a result of the wager i.e. whether the user has won or lost the wager. Based on the comparison of the result of the live event 15702 and the wagers placed by the user, the result of the wager may be used to calculate the balance amount for the user. For example, the result of the live event 15702, i.e. Alshon Jeffery of Philadelphia Eagles, playing during 3rd quarter against the New England Patriots scored a touchdown, and the wager of $100 placed on Alshon Jeffery for scoring a touchdown, are compared to determine the result of the wager i.e. a win for the user. In this example, the user would make a profit of $400, as per the initial wager ($100) placed at odds of 4/1. Thus, the updated balance of the user (with an opening balance of $2000), after the completion of the live event 15702, will be $2000+$400=$2400. Further, the updated balance of $2400 of the user may be updated in the fantasy user database 15720. Further, the wagering module 15724 monitors the live event 15702, until a predefined condition is met. In one exemplary embodiment, the predefined condition may be that the user has logged out of the live event 15702 or the live event 15702 has ended. In addition, at the end of the live event 15702, the user may be prompted with a message reminder for a next live event, as a recommendation.

Further, embodiments may include a mobile device 15726 such as a computing device, laptop, smartphone, tablet, computer, smart speaker, or I/O devices. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allow for voice recognition and inputs, including, e.g., Microsoft KINECT, SIRI for IPHONE by Apple, Google Now or Google Voice Search. Additional mobile devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also allow storage and/or an installation medium for the computing device. In still other embodiments, the computing device may allow USB connections (not shown) to receive handheld USB storage devices. In further embodiments, an I/O device may be a bridge between a system bus and an external communication bus, e.g. a USB bus, a SCSI bus, a FireWire bus, an Ethernet bus, a Gigabit Ethernet bus, a Fiber Channel bus, or a Thunderbolt bus. Further, the mobile device 15726 could be an optional component and would be utilized in a situation in which the paired wearable device is utilizing the mobile device as additional memory or computing power or connection to the internet.

Further, embodiments may include a fantasy sports app 15728 which allow the user to log-in/sign-in the fantasy sports app 15728, during the live event 15702. The fantasy sports app 15728 allows the user to make a fantasy roster of players related to the live event 15702. In one embodiment, the fantasy sports app 15728 may present a number of contests related to a particular live event 15702. In an example, for a particular live event 15702, the fantasy sports app 15728 may present a contest with an entry fee of $9, offering 10 users to play that contest and a winning amount of $80 for the winner. In another example, for the same live event 15702, in which the fantasy sports app 15728 may present a contest with an entry fee of $100, offering 10 users to play that contest, and a winning amount of $900 for the winner. The user may be able to make a fantasy roster from the teams involved in the live event 15702. Further, the user may be asked to prepare the fantasy roster before a predefined time from the start of the live event 15702. For example, user Casey Huke creates a roster including Alshon Jeffery, Jalen Hurts, and DeScan Jackson from Philadelphia Eagles in the Draftkings app for the contest with the entry fee of $100. In one embodiment, the fantasy sports app 15728 may present the user with the wagers available, related to a particular live event 15702, received via the base fantasy module 15722. Further, the fantasy sports app 15728 may store information related to the rosters created by the user, in the fantasy user database 15720. Further, when the live event 15702 concludes, the players of the roster created by the user, may be verified, for final settlement on the wager. Based on the verification of the roster and the result of the live event 15702, the fantasy sports app 15728 may facilitate settlement of balances for the user. In one embodiment, the balances of the user may be updated in the fantasy user database 15720. In one embodiment, the fantasy sports app 15728 may trigger a third-party balance settlement apps linked to the fantasy sports app 15728, for settlement of the balances of the user. For example, Draftkings app may use PayPal for settlement of the balances of the user.

FIG. 158 illustrates the base fantasy module. The base fantasy module 15722 is triggered when the user logs-in, at step 15800, to the fantasy sports network 15718 through an app on the mobile device 15726 i.e. fantasy sports app 15728. The base fantasy module 15722 may facilitate the user to place in-play wagers. After logging in to the fantasy sports app 15728, the base fantasy module 15722 may retrieve, at step 15802, the fantasy roster created by the user, using the fantasy sports app 15728. In one embodiment, the fantasy roster may be retrieved from the fantasy user database 15720. For example, a fantasy roaster including Alshon Jeffery, Jalen Hurts, and DeScan Jackson from Philadelphia Eagles in the Draftkings app, is retrieved from the fantasy user database 15720. The base fantasy module 15722 may receive, at step 15804, data related to the live event 15702. In one embodiment, the data related to the live event 15702, may be received from the sensor feeds 15704. For example, the base fantasy module 15722 receives data that Alshon Jeffery is playing in the live event 15702. Based on the retrieved fantasy roster and received data related to the live event 15702, the base fantasy module 15722 may identify, at step 15806, the players on the fantasy roster that are playing in the live event 15702. In one example embodiment, the base fantasy module 15722 may identify the players that are on offense in the live event 15702. For example, Alshon Jeffery is a part of the fantasy roster and is playing on offense in the live event 15702. Based on the identified players on the fantasy roster that are playing in the live event 15702, the base fantasy module 15722 may determine, at step 15808, if a wager is available for the fantasy roster player. In one case, if a wager is available for the fantasy roster player, then the base fantasy module 15722 may display available wagers to the user. For example, a wager of $100 is available for Alshon Jeffery, for scoring a touchdown with odds of 4/1. In another case, if no wager is available for the fantasy roster player, then the base fantasy module 15722 may return to step 15804, to continue receiving data related to the live event 15702. Based on the determination that a wager is available for the fantasy roster player, then the base fantasy module 15722, may display, at step 15810, the available wagers to the user. In one embodiment, the available wagers may be displayed to the user on the mobile device 15726. For example, the available wager of $100 for Alshon Jeffery, for scoring a touchdown with odds of 4/1, is displayed to the user Casey Huke. Further, the wager may be displayed in various forms such as, but not limiting to, the player with the available wager can be highlighted, all the players on offense can be highlighted (i.e. considering wager is available for players on offense), or the wagers can be displayed on the player's representation on the user's fantasy roster. In another embodiment, due to limited screen space on the mobile device 15726, sub-menus may be displayed on the highlighted player with available wager or the highlighted players on offense, to allow for more wagers to be displayed. Further, the base fantasy module 15722 may determine whether the user selects, at step 15812, a wager to be placed. In one case, if the user selects a wager to be placed, then the base fantasy module 15722 may trigger the wagering module 15724. For example, the user selects the wager of $100 to be placed on Alshon Jeffery for scoring a touchdown. In another case, if no wager is selected by the user, then the base fantasy module 15722 may return to step 15804, to continue receiving data related to the live event 15702. Based on the determination that the user selects the wager to be placed, the base fantasy module 15722 may trigger, at step 15814, the wagering module 15724. The base fantasy module 15722 may constantly monitor, at step 15816, the live event 15702, for completion. In one case, when the live event 15702 is not concluded, the base fantasy module 15722 may return to step 15804, to continue receiving data related to the live event 15702. In another case, when the live event 15702 is concluded, then the program moves to step 15820, to end the process. The base fantasy module 15722 may also constantly monitor, at step 15818 if the user logs-off from the app, during the live event 15702. In one case, when the user does not logs-off from the fantasy sports app 15728, then the base fantasy module 15722 may return to step 15804, to continue receiving data related to the live event 15702. In another case, when the user logs-off from the app, then the program moves to step 15820, to end the process. Thereafter, the program ends, at step 15820.

FIG. 159 illustrates the wagering module. The wagering module 15724 may receive a prompt, at step 15900, from the base fantasy module 15722. It can be noted that the wagering module 15724 is triggered when the user wants to place a wager in the live event 15702. For example, the wager may be available for Alshon Jeffery of $100 with odds at 4/1 for scoring a touchdown. After receiving the prompt from the base fantasy module 15722, the wagering module 15724 may constantly monitor, at step 15902, the live event 15702, for completion. In one case, when the live event 15702 is concluded, then the wagering module 15724 may proceed to compare the result of the live event 15702 with the wager placed by the user. For example, the result of the live event 15702 is that Alshon Jeffery scored a touchdown during the live event 15702. In another case, when the live event 15702 is not concluded, then the wagering module 15724 may continue monitoring the live event 15702 for completion. The wagering module 15724 may compare, at step 15904, the result of the live event 15702 with the wagers placed by the user, to determine a result i.e. whether the user has won or lost. In this example, the result of the live event 15702 indicates that Alshon Jeffery scored a touchdown, against the condition of wager of $100, placed on Alshon Jeffery for scoring a touchdown, are compared to determine the result of the wager i.e. a win for the user. Based on the comparison of the result of the live event 15702 and the wagers placed by the user, the balance amount may be calculated, at step 15906, for the user. For example, if Alshon Jeffrey of Philadelphia Eagles, playing 3rd quarter against the New England Patriots, scores a touchdown, then the user would make a profit of $400, as per the initial wager ($100) placed at odds of +400. Thus, the updated balance of the user (with an opening balance of $2000), after the completion of the live event 15702, will be $2000+$400=$2400. Further, the wagering module 15724 will update, at step 15906, the account balance of the user who places the wager in the fantasy user database 15720. In this example, after winning the wager of $100 placed at +400 odds, the updated balance of the user is $2400.

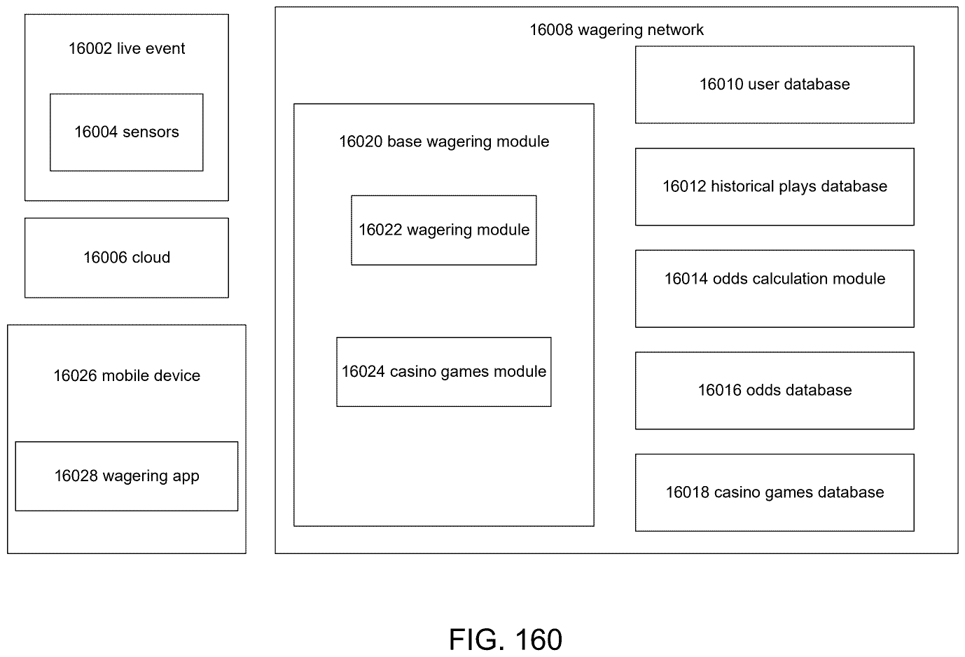

FIG. 160 illustrates a system for casino gaming during breaks in live sporting event, according to an embodiment.

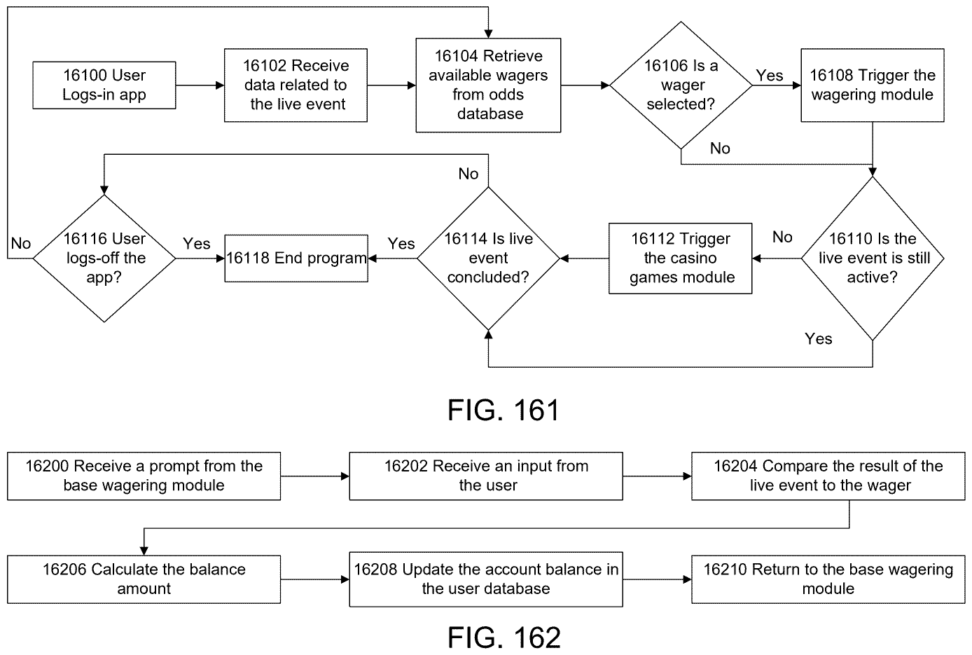

FIG. 161 illustrates a base wagering module, according to an embodiment.

FIG. 162 illustrates a wagering module, according to an embodiment.

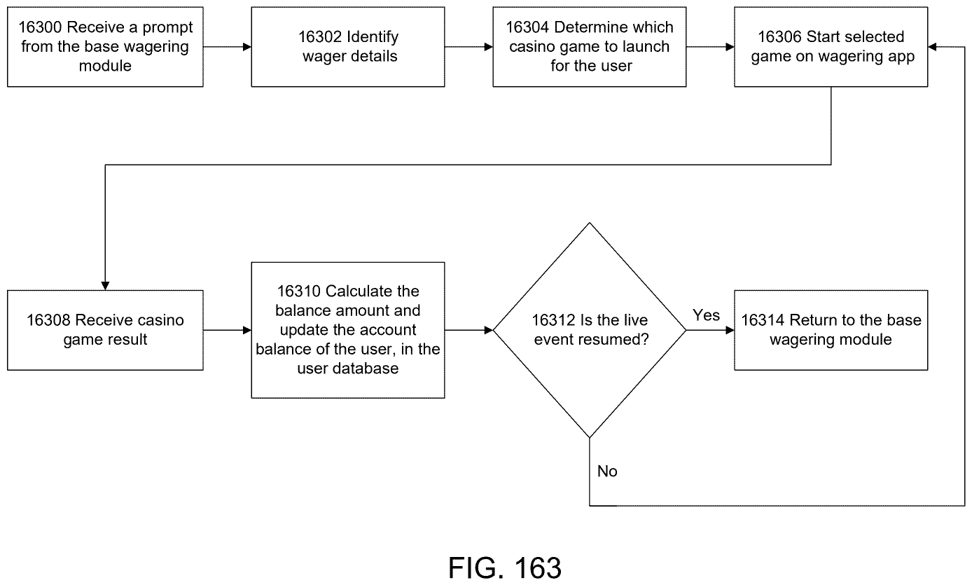

FIG. 163 illustrates a casino games module, according to an embodiment.

FIG. 160 is a system for casino gaming during breaks in live sporting event. This system comprises of a live event 16002, for example, a sporting event such as a football game, a basketball game, a hockey game, a tennis match, golf tournament, eSports or digital game, etc. The live event 16002 will include some number of actions or plays, upon which a user, bettor or customer can place a bet or wager, typically through an entity called a sportsbook. There are numerous types of wagers the bettor can make, including a straight bet, a money line bet, a bet with a point spread or line that bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round-robin, or other styles of tournaments. There are other types of wagers, including parlays, teasers and prop bets that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 16002, such as the score of American football or the run line in baseball, or a series of action in the live event 16002. Sportsbooks have a number of bets they can handle, a limit of wagers they can take on either side of a bet before they will move the line or odds off of the opening line. Additionally, there are circumstance, such an injury to an important player such as a listed pitcher, in which a sportsbook, casino or racino will take an available wager off the board. As the line moves there becomes an opportunity for a bettor to bet on both sides at different point spreads to middle and win both bets. Sportsbooks will often offer bets on portions of games, such as first half bets and half-time bets. Additionally, the sportsbook can offer futures bets on live events 16002 in the future. Sportsbooks need to offer payment processing services to cash out customers. This can be done at kiosks at the live event 16002 or another location. For example, considering a live event 16002 may be a baseball game that is played between the New York Yankees and the Los Angeles Dodgers, at Yankee Stadium, New York City.

Further, embodiments may include a plurality of sensors 16004 that may be used such as motion sensors, temperature sensors, humidity sensors, cameras such as an RGB-D camera which is a digital camera capturing color (RGB) and depth information for every pixel in an image, microphones, a radiofrequency receiver, a thermal imager, a radar device, a LIDAR device, an ultrasound device, a speaker, wearable devices etc. Also, the plurality of sensors 16004 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that collects statistical information through real-time X, Y positioning of players and X, Y, Z positioning of the ball. In the example of a baseball game, the plurality of sensors 16004 may be used for capturing parameters such as spin rate of the ball, speed of the ball, ball positions, launch angle, and exit velocity.

Further, embodiments may include a cloud 16006 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable resources and higher-level services that can be rapidly provisioned with minimal management effort, often over internet and relies on sharing of resources to achieve coherence and economics of scale, like a public utility, while third-party clouds enable organizations to focus on their core businesses instead of expending resources on computer infrastructure and maintenance. The cloud 16006 may be communicatively coupled to the wagering network 16008 which may perform real time analysis on the type of play and the result of the play. The cloud 16006 may also be synchronized with game situational data, such as the time of the game, the score, location on the field, weather conditions, and the like which may affect the choice of play utilized. For example, in other embodiments, the cloud 16006 may not receive data gathered from sensors and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various embodiments herein.

Further, embodiments may include the wagering network 16008 which may perform real-time analysis on the type of play and the result of a play or action. The wagering network 16008 (or cloud 16006) may also be synchronized with game situational data, such as the time of the game, the score, location on the field, weather conditions, and the like which may affect the choice of play utilized. For example, in other embodiments, the wagering network 16008 may not receive data gathered from sensors and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various embodiments herein. The wagering network 16008 can offer a number of software as a service managed services such as, user interface service, risk management service, compliance, pricing and trading service, IT support of the technology platform, business applications, game configuration, state-based integration, integration to allow the joining of social media, as well as marketing support services that can create engaging promotions to the user. In one embodiment, the wagering network 16008 may facilitate the user with settlement options related to the wager. In another embodiment, the wagering network 16008 may use third party balance settlement apps linked to a wagering app 16028, for settlement of the balances of the user. For example, the wagering app 16028 may use Paypal for settlement of the balances of the user.

Further, embodiments may utilize a user database 16010 which contains data relevant to all users of the wagering network 16008, which may include, a user ID, a device identifier, a paired device identifier, wagering history, and account balance i.e. wallet information for the user. The user database 16010 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 16010 may contain betting lines and search queries. The user database 16010 may be searched based on a search criteria received from the user. Each betting line may include a plurality of betting attributes such as at least one of the live event 16002, a team, a player, an amount of wager, etc. The user database 16010 may include information related to all the users involved in the live event 16002. In one example embodiment, the user database 16010 may include information for generating a user authenticity report and a wagering verification report. Further, the user database 16010 may be used to store user statistics like, but not limiting to, retention period for a particular user, frequency of wagers placed by a particular user, details of previous in-play wager placed by a particular user, average amount of wager placed by each user, etc. Further, the user database 16010 may also contain information related to casino games played by the user, result of the previously played casino games, etc.

Further, embodiments may utilize a historical plays database 16012 that contains play data for the type of sport being played in the live event 16002. In one embodiment, for optimal odds calculation, the historical play data may include metadata about the historical plays, such as time of the live event 16002, location, weather, previous plays, opponent, physiological data of the players (including blood pressure, pulse rate, and respiration rate), batting average of all players, information related to the players such as injuries in the past, batting average, earned run average, catch probability, spin rate, launch angle, exit velocity, information related to trainers of each player, etc. For example, in the baseball game, information stored in the historical plays database 16012 may include information related to the previous baseball games played by the New York Yankees such as, but not limited to, the weather condition, i.e. during the match, it was cloudy.

Further, embodiments may include an odds calculation module 16014 which utilizes information from the historical plays database 16012 and the information from the sensor feeds 16004 to calculate odds for in-play wagers. The information from the historical plays database 16012 may include data related to the type of the play, the previous information related to players involved in the live event 16002, and results of the previous live events 16002. The odds for each live event 16002, such as in a baseball game, a particular player hitting a home run, a single, or a strikeout, may be calculated based on the information received from the sensor feeds 16004 and the previous information related to the particular player. Further, the odds may be updated based on in-game events (for example, a player strikes a home run with the same pitcher, decreasing his odds of getting a strikeout from the same pitcher). The odds may be calculated or adjusted based on statistical information related to the live event 16002 and the statistical information of the players. For example, the odds may be determined based on the historical data such as prior performance information about a player (like batting average against a certain pitcher, earned run average, catch probability, hamstring strain), and physiological information of player(s) etc., and current i.e. real-time information, such as current confidence level etc. In one embodiment, the type of wagering may depend on the type of game being played. In one embodiment, the odds calculation module 16014 may determine the available wagers to the user. The odds calculation module 16014 may also utilize a probability engine, which assembles all the historical data and real-time data and produces the odds (stored in the odds database 16016) for in-play wagers. Thus, the odds calculation module 16014 may contain information relevant to all the potential outcomes, as available wagers, which facilitates the user with a better knowledge to make certain judgements about the potential performance of players in each live event 16002 and place a calculated wager with a potential return on the wager. For example, in the baseball game, the odds calculation module 16014 may calculate odds related to the possible outcomes of an at-bat for Aaron Judge of the New York Yankees hitting against Clayton Kershaw of the LA Dodgers, such that the odds of hitting a single are 4/1 (in moneyline+400), hitting a double are 5/1, hitting a home run are 3/1, and a strikeout are 2/1.

Further, embodiments may utilize an odds database 16016 that contains the odds calculated by the odds calculation module 16014. The odds database 16016 stores all the odds and may be used by a base wagering module 16020 to facilitate the user with wagering opportunities, through the wagering app 16028. In one embodiment, the type of wagering may depend on the type of game being played.

Further, embodiments may utilize a casino games database 16018 that contains play data for casino games, or other playable games, that can be offered to the user, when the live event 16002 is inactive or during a break of the live event 16002. The casino games may be, but are not limited to, digital poker, slots, craps, blackjack, roulette, or baccarat. Alternatively, in other embodiments, the casino games may be any playable games, regardless of whether or not they are wagering games or traditional casino games, such as arcade games, video games, and the like. Further, the casino games database 16018 may store casino games that can be offered to a particular user, based on different user characteristics or predefined thresholds of previous in-play wagers placed by the user and may be used by the casino games module 16024 to allow the user to play a casino game, via the app. In one embodiment, the user characteristics may include user's historical data such as the user's previous in-play wager, the user's wager frequency, number of times the user has played a particular game, time spent on each casino game, wager size, time since last play, user's browsing history, result of the user's previous in-play wager, etc. In one embodiment, the casino games database 16018 may store predefined thresholds of the wager size. For example, in one case, if the predefined threshold is $20 and the wager size of the user is less than $20, then the casino games database 16018 may store a corresponding game of slots. In another case, if the wager size of the user is more than $20, then the casino games database 16018 may store a corresponding game of digital poker. In another embodiment, the casino games database 16018 may store casino games based on the last wager placed by the user. For example, in one case, if the previous in-play wager was placed recently, then the casino games database 16018 may store a corresponding game of blackjack. In another case, if the previous in-play wager was not placed within a predefined time before the start of break, then the casino games database 16018 may store a corresponding game of digital poker. In another embodiment, the casino games database 16018 may store casino games based on the user's wager frequency. For example, if the user has placed more than 10 wagers in last one hour, then the casino games database 16018 may store a corresponding game of roulette and if the user has placed less than 10 wagers in the last one hour, then the casino games database 16018 may store a corresponding game of digital poker. In yet another embodiment, the casino games database 16018 may store casino games to be offered to a particular user, based on the result of the user's previous wager. For example, in one case, if the user has won the previous wager, then the casino games database 16018 may store a game of slots for the user. In another case, if the user has lost the previous wager, then the casino games database 16018 may store a corresponding game of blackjack. In another example embodiment, the casino games database 16018 may store casino games to be offered to a particular user, based on the casino games played in the pastor casino games that the user has shown interest in the past.

Further, embodiments may include the base wagering module 16020 that allows the user to place in-play wagers. The base wagering module 16020 may allow the user to log-in/sign-in to the wagering network 108 through the wagering app 16028 on a mobile device 16026, during the live event 16002. After logging in to the wagering app 16028, the base wagering module 16020 may receive data related to the live event 16002. In one embodiment, the data related to the live event 16002, may be received from the sensors 16004. For example, the base wagering module 16020 receives data that in the baseball game, Aaron Judge of the New York Yankees, playing the 3rd inning against Clayton Kershaw of the LA Dodgers. Further, the base wagering module 16020 may retrieve all available wagers related to the live event 16002, from the odds database 16016. For example, the available wagers include a wager of $100 on Aaron Judge of the New York Yankees, playing the 3rd inning against Clayton Kershaw of the LA dodgers, hitting a single at odds of 4/1 and a wager of $400 on Aaron Judge of the New York Yankees, playing the 3rd inning against Clayton Kershaw of the LA Dodgers, hitting a homerun at odds of 5/1. Further, the base wagering module 120 may check for wager selection. In one case, if the wager is selected by a user, then the base wagering module 16020 may trigger a wagering module 16022. For example, the user selects a wager of $100 on Aaron Judge of the New York Yankees, playing the 3rd inning against Clayton Kershaw of the LA Dodgers, hitting a single. In another case, if no wager is selected by the user, then the base wagering module 16020 may determine if the live event 16002 is still active i.e. if there is a commercial or other break during the live event 16002. In one embodiment, the break may be an injury break, review break, or innings break. In one case, if the live event 16002 is still active, then the base wagering module 16020 may continue retrieving the available wagers. In another case, if the live event 16002 is not active, then the base wagering module 120 may trigger the casino games module 16024 to facilitate the user to play casino games. Thereafter, the base wagering module 16020 may constantly monitor if the live event 16002 is concluded or if the user logs-off from the app i.e. wagering app 16028, during the live event 16002.

Further, embodiments may include a wagering module 16022 which is triggered when a wager is placed by the user in the live event 16002, via the base wagering module 16020. After receiving the prompt from the base wagering module 16020, the wagering module 16022 may receive an input from the user. The input may correspond to a wager placed by the user. For example, the user places a wager of $100 on Aaron Judge of the New York Yankees, playing the 3rd inning against Clayton Kershaw of the LA Dodgers, hitting a single. Further, the wagering module 16022 may compare the result of the live event 16002 with the wagers placed by the user, to determine a result i.e. whether the user has won or lost the wager. Based on the comparison of the result of the live event 16002 and the wagers placed by the user, the result of the wager may be used to calculate the balance amount for the user. For example, the result of the live event 16002 is Aaron Judge hits a single and the wager of $100 on Aaron Judge hitting a single, are compared to determine the result of the wager i.e. a win for the user. In this example, the user would make a profit of $400, as per the initial wager ($100) placed at odds of 4/1. Thus, the updated balance of the user (with an opening balance of $2000), after the completion of the live event 16002, will be $2000+$400=$2400. Further, the updated balance of $2400 of the user may be updated in the user database 16010. Further, the wagering module 16022 monitors the live event 16002, until a predefined condition is met. In one exemplary embodiment, the predefined condition may be that the user has logged out of the live event 16002 or the live event 16002 has ended. In addition, at the end of the live event 16002, the user may be prompted with a message reminder for a next live event, as a recommendation.

Further, embodiments may include the casino games module 16024, which allows a user to play a casino game. It may be appreciated that, in some embodiments, the casino games module 16024 may be referred to as a games module 16024, as the games may be any type of game (such as video games or arcade games), and are not limited to casino games. The casino games module 16024 may receive a prompt from the base wagering module 16020, to suggest/launch a casino game(s) from a number of casino games when the live event 16002 is not active i.e. during a commercial or other breaks in action during the live event 16002. In one embodiment, the break may be injury break, review break, or innings break. The casino games module 16024 may utilize information from the user database 16010 and the casino games database 16018 to identify wager details such as, but not limited to, threshold value of the wager size, previous in-play wager, wager frequency, number of times the user has played a particular game, time spent on each game, time since last game was played, etc. Further, the casino games module 11604 may determine which casino game(s) to launch for the user. In one embodiment, the determination of which casino game to launch for the user, may be based at least on the wager size, wager frequency, last wager, or result of user's previous wager, timing of the previous in-play wager placed by the user. In one embodiment, the casino games module 16024 may launch a particular game, based on a predefined threshold of the wager size. For example, in one case, if the predefined threshold is $20 and the wager size of the user is less than $20, then the casino games module 16024 may offer slots to the user. In another case, if the wager size of the user is more than $20, then the casino games module 16024 may offer digital poker to the user. In another embodiment, the casino games module 16024 may launch a particular game, based on the last wager placed by the user. For example, in one case, if the previous in-play wager was placed recently, then the casino games module 16024 may offer blackjack to the user. In another case, if the previous in-play wager was not placed within a predefined time before the start of break, then the casino games module 16024 may offer digital poker to the user. In another embodiment, the casino games module 16024 may launch a particular game, based on the user's wager frequency. For example, if the user has placed more than 10 wagers in last one hour, then roulette may be launched. In another case, if the user has placed less than 10 wagers in the last one hour, then the digital poker may be launched. In yet another embodiment, the casino games module 16024 may launch a particular game, based on the result of user's previous wager. For example, in one case, if the user has won the previous wager, then a game of slots may be launched. In another case, if the user has lost the previous wager, then a game of blackjack may be launched. In this example, when the wager size of $100 is identified, then a game of digital poker is determined to be launched for the user. In another embodiment, the casino games module 16024 may launch a particular casino game based on a playing position of the player, on which the user has placed the wager. For example, the casino games module 16024 may offer slots, if the user has placed a wager on a player i.e. on defense. In another embodiment, the casino games module 16024 may suggest a particular casino game, instead of directly launching the casino game. In one example embodiment, the casino games module 16024 may suggest a suite of casino games to the user, so that the user can choose a particular casino game from the suite of games. In one embodiment, the casino games module 16024 may use artificial intelligence to suggest the casino games to the user. For example, based on the wager of $100 placed by the user, the casino games module 16024 may suggest blackjack and/or digital poker to the user. Based on the determined casino game to be launched/suggested for the user, the casino games module 16024 may start the selected game on the wagering app 16028. Further, the casino games module 16024 may receive a result of the casino game. The result of the casino game may be the user has won or lost or had a tie (in case of a multiplayer game). For example, the casino games module 16024 starts the game of digital poker on the wagering app 16028 and the result of the digital poker is that the user wins the hand of the pot size of $500 when the user placed an ante of $10 and further raised the bet by $40. Based on the result of the casino game, the balance amount may be calculated for the user. For example, the user wins the pot size of $500 played with an ante of $10 and total bet of $50. Thus, the updated balance of the user (with an opening balance of $2400), after the completion of the casino game(s), will be $2400-$50+$500=$2850. Further, the casino games module 16024 will update the account balance of the user who places the wager in the user database 16010. In this example, after winning the pot size of $500 played with an ante of $10 and total bet of $50, the updated balance of the user is $2850. Further, the casino games module 16024 may constantly monitor if the live event 16002 resumes. In one case, when the live event 16002 is not resumed, then the casino games module 16024 may facilitate the user to continue playing casino games. In another case, when the live event 16002 is resumed, then the user may be notified and may have an option to exit the casino game, to return to the live event 16002 or continue playing the casino game. In one embodiment, when the user exits the casino game to return to the live event 16002, then the user's wager may stand void and thereafter, the base wagering module 16020 may be triggered. In another embodiment, if the live event 16002 restarts in between the duration of the casino game, then the user may either choose to exit the casino game or to save the casino game play. It can be noted that the user may be able to save the progress of the casino game, based on the type of casino game.

Further, embodiments may include the mobile device 16026 such as a computing device, laptop, smartphone, tablet, computer, smart speaker, or I/O devices. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allow for voice recognition and inputs, including, e.g., Microsoft KINECT, SIRI for IPHONE by Apple, Google Now or Google Voice Search. Additional mobile devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also allow storage and/or an installation medium for the computing device. In still other embodiments, the computing device may allow USB connections to receive handheld USB storage devices. In further embodiments, an I/O device may be a bridge between a system bus and an external communication bus, e.g. a USB bus, a SCSI bus, a FireWire bus, an Ethernet bus, a Gigabit Ethernet bus, a Fiber Channel bus, or a Thunderbolt bus. Further, the mobile device 16026 could be an optional component and would be utilized in a situation in which the paired wearable device is utilizing the mobile device 16026 as additional memory or computing power or connection to the internet.

Further, embodiments may include the wagering app 16028 which allows the user to place in-play wagers during the live event 16002. In one embodiment, the wagering app 16028 may be a mobile application or web application, which runs on the mobile device 16026. The wagering app 16028 may allow the user to receive data related to the live event 16002. For example, in the baseball game, Aaron Judge of the New York Yankees, playing the 3rd inning against Clayton Kershaw of LA Dodgers. In one embodiment, the wagering app 16028 may present the user with the wagers available, related to a particular live event 16002. Further, the wagering app 16028 may allow the user to place in-play wagers corresponding to the available wagers. In one embodiment, the wagering app 16028 may facilitate the user with an interface i.e. a graphical user interface (GUI) for performing various operations such as, but not limited to, playing casino games, linking other applications with the wagering app 16028, storing user's personal details, etc. In one embodiment, the wagering app 16028 may store information related to the placed wagers. In another embodiment, the wagering app 16028 may facilitate the user to set reminders related to a particular live event 16002. Further, when the live event 16002 concludes, the wagering app 16028 may facilitate settlement of balances for the user. In another embodiment, the wagering app 16028 may trigger third party balance settlement apps linked to the wagering app 16028, for settlement of the balances of the user. For example, the wagering app 16028 may use Paypal for settlement of the balances of the user.

FIG. 161 illustrates the base wagering module 16020. The base wagering module 16020 is triggered when the user logs-in, at step 16100, to the wagering network 108 through the wagering app 16028, on the mobile device 16026. The base wagering module 16020 may facilitate the user to place in-play wagers. After logging in to the wagering app 16028, the base wagering module 16020 may receive, at step 16102, data related to the live event 16002. In one embodiment, the data related to the live event 16002, may be received from the sensors 16004. For example, the base wagering module 16020 receives data that in the baseball game, Aaron Judge of the New York Yankees, playing the 3rd inning against Clayton Kershaw of the LA Dodgers. The base wagering module 16020 may retrieve, at step 16104, available wagers from the odds database 16016. For example, the available wagers include a wager of $100 on Aaron Judge of the New York Yankees, playing the 3rd inning against Clayton Kershaw of LA Dodgers, hitting a single at odds of 4/1 and a wager of $400 on hitting a homerun at odds of 5/1. After retrieving the available wagers, the base wagering module 16020 may determine whether the user selects, at step 16106, a wager to be placed. In one case, if the user selects a wager to be placed, then the base wagering module 16020 may trigger a wagering module 16022. For example, the user selects a wager of $100 on Aaron Judge of the New York Yankees, playing the 3rd inning against Clayton Kershaw of the LA Dodgers, hitting a single. Based on the determination that the user selects the wager to be placed, the base wagering module 16020 may trigger, at step 16108, the wagering module 16022. In another case, if no wager is selected by the user, at step 16106, then the base wagering module 16020 may determine, at step 16110, if the live event 16002 is still active i.e. on a commercial or other break during the live event 16002. In one embodiment, the break may be an injury break, review break, or innings break. In one case, if the live event 16002 is still active, then the base wagering module 16020 may at step 16104 retrieve the available wagers from the odds database 16016. In another case, if the live event 16002 is not active, then the base wagering module 16020 may trigger the casino games module 16024 to facilitate the user to play casino games. Based on the determination that the live event 16002 is not active, then the base wagering module 16020 may trigger, at step 16112, the casino games module 16024. The base wagering module 16020 may constantly monitor, at step 16114, the live event 16002 for completion. In one case, when the live event 16002 is concluded, then the base wagering module 16020 may again trigger the wagering module 16022, to conclude on the wagers placed by the user. In another case, when the live event 16002 is not concluded, then the base wagering module 16020 may return to, step 16104, to retrieve available wagers. The base wagering module 16020 may also constantly monitor, at step 16116, if the user logs-off from the wagering app 16028, during the live event 16002. In one case, when the user logs-off from the wagering app 16028, then the base wagering module 16020 may again trigger the wagering module 16022, to conclude on the wagers placed by the user. In another case, when the user does not logs-off from the wagering app 16028, then the base wagering module 16020 may return to, step 16104, to retrieve available wagers. Thereafter, the program ends, at step 16118.

FIG. 162 illustrates the wagering module 16022. The wagering module 16022 may receive, at step 16200, a prompt from the base wagering module 16020. It can be noted that the wagering module 16022 is triggered when the user wants to place a wager during the live event 16002. For example, a user wants to place a wager of $100 on Aaron Judge of the New York Yankees, playing the 3rd inning against Clayton Kershaw of the LA Dodgers, hitting a single. The wagering module 16022 may receive, at step 16202, an input from the user. The input may correspond to a wager placed by the user. For example, the user places a wager of $100 on Aaron Judge of the New York Yankees, playing the 3rd inning against Clayton Kershaw of the LA Dodgers, hitting a single. Further, the wagering module 16022 may compare, at step 16204, the result of the live event 16002 with the wagers placed by the user, to determine a result i.e. whether the user has won or lost. In this example, the wager of $100 placed for Aaron Judge hitting a single and the result of the live event 16002 i.e. Aaron Judge hitting a single, are compared to determine the result of the wager i.e. a win for the user. Based on the comparison of the result of the live event 16002 and the wager placed by the user, the balance amount may be calculated, at step 16206, for the user. For example, the user wins the wager of $100 at +400 odds that Aaron Judge will hit a single on the next play and the result of the live event 16002 is Aaron Judge hits a single. Thus, the updated balance of the user (with an opening balance of $2000), after the completion of the live event 16002, will be $2000+$400=$2400. Further, the wagering module 16022 may update, at step 16208, the account balance of the user who place the wager, in the user database 16010. In this example, after winning the wager of $100 placed at +400 odds, the updated balance of the user is $2400. Thereafter, the process returns, at step 16210, to the base wagering module 16020.

FIG. 163 illustrates the casino games module 16024. The casino games module 16024 may receive, at step 16300, a prompt from the base wagering module 16020. It can be noted that the casino games module 16024 is triggered by the base wagering module 16020, to launch a casino game from a number of casino games. Further, the casino games module 16024 may identify, at step 16302, wager details. The wager details may include, but are not limited to, last wager placed by the user, wager size, last play, a threshold value of the wager size, previous in-play wagers, wager frequency, time spent on each game, time since last game was played, etc. For example, a wager size of $100 is identified. Based on the identified wager details, the casino games module 16024 may determine, at step 16304, which casino game to launch for the user. In one embodiment, the determination of which casino game to launch for the user, may be based at least on the wager size, wager frequency, last wager, or result of user's previous wager, timing of the previous in-play wager placed by the user. In one embodiment, the casino games module 16024 may launch a particular game, based on predefined threshold of the wager size. For example, in one case, if the predefined threshold is $20 and the wager size of the user is less than $20, then the casino games module 16024 may offer slots to the user as it is a casino game that lends itself well to a large number of low dollar wagers. In another case, if the wager size of the user is more than $20, then the casino games module 16024 may offer digital poker to the user as it is a game that can offer higher stakes per game. In another embodiment, the casino games module 16024 may launch a particular game, based on the last wager placed by the user. For example, in one case, if the previous in-play wager was placed recently, then the casino games module 16024 may offer blackjack to the user to attempt to continue the cadence of wagers the user has been making. In another case, if the previous in-play wager was not placed within a predefined time before the start of break, then the casino games module 16024 may offer a digital poker, or, in general, a casino game whose pace is related to the pace of wagers and/or wagering history of the user, to the user based on that user's history of wagering more on digital poker than any other available casino game. In another embodiment, the casino games module 16024 may launch a particular game, based on the user's wager frequency. For example, if the user has placed more than 10 wagers in last one hour, then roulette may be launched as it is a casino game that offers a large number of available wagers in a short amount of time. In another case, if the user has placed less than 10 wagers in the last one hour, then the digital poker may be launched as it provides the user with more of a sense of control over the outcome to encourage wagering in the currently stagnant user. In yet another embodiment, the casino games module 16024 may launch a particular game, based on the result of user's previous wager. For example, in one case, if the user has won the previous wager, then a game of slots may be launched to give the user the immediate opportunity to win another wager. In another case, if the user has lost the previous wager, then a game of blackjack may be launched to present the user with a casino game that offers user better odds against the house in order to present the user with an option to attempt to win back their losses. In this example, when the wager size of $100 is identified as being above the wager size threshold of $20, then a game of digital poker is launched for the user. While these examples are used as single binary options, in other embodiments they can be used in combination. For example, if the user's most recent wager is above the wager size threshold, the system may then look at wager frequency and choose a casino game, such as Baccarat, due to the user's frequent high dollar value wagers and Baccarat's reputation as a game for high rollers. Based on the determined casino game to be launched for the user, the casino games module 16024 may start, at step 16306, the selected game on the wagering app 16028. Further, the casino games module 16024 may receive, at step 16308, a result of the casino game. The result of the casino game may be the user has won or lost or had a tie (in case of a multiplayer game). For example, the result of the digital poker is that the user wins the hand of the pot size of $500 when the user placed an ante of $10 and further raised the bet by $40. Based on the result of the casino game, the balance amount may be calculated, at step 16310, for the user. For example, the user wins the pot size of $500 played with an ante of $10 and total bet of $50. Thus, the updated balance of the user (with an opening balance of $2400), after the completion of the casino game(s), will be $2400-$50+$500=$2850. Further, the casino games module 16024 will update, at step 16310, the account balance of the user who places the wager in the user database 16010. In this example, after winning the pot size of $500 played with an ante of $10 and total bet of $50, the updated balance of the user is $2850. Further, the casino games module 16024 may constantly monitor, at step 16312, if the live event 16002 resumes. In one case, when the live event 16002 is not resumed, then the casino games module 16024 may facilitate the user to continue playing casino games. In another case, when the live event 16002 is resumed, then the user may be notified and may have an option to exit the casino game, to return to the live event 16002 or continue playing the casino game. In one embodiment, when the user exits the casino game to return to the live event 16002, then the user's wager may stand void and thereafter, the base wagering module 16020 may be triggered. Thereafter, the process returns, at step 16314, to the base wagering module 16020.

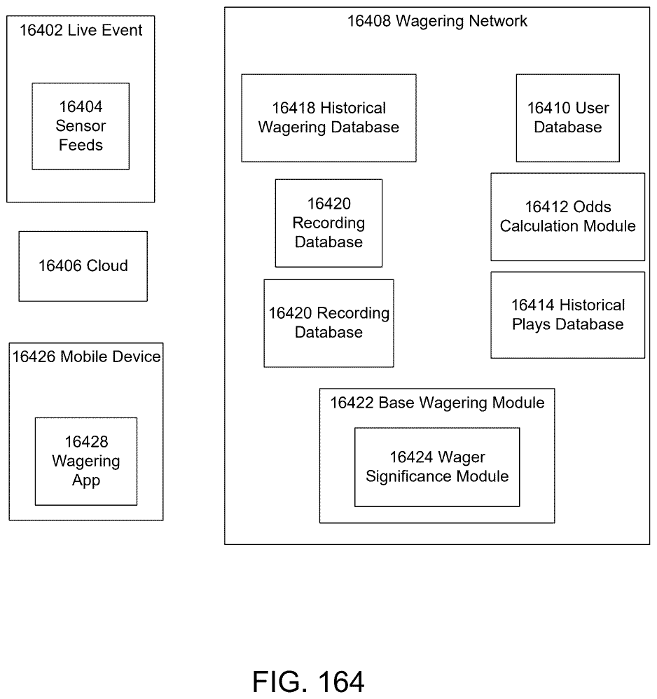

FIG. 164 illustrates a system for wagering, according to an embodiment.

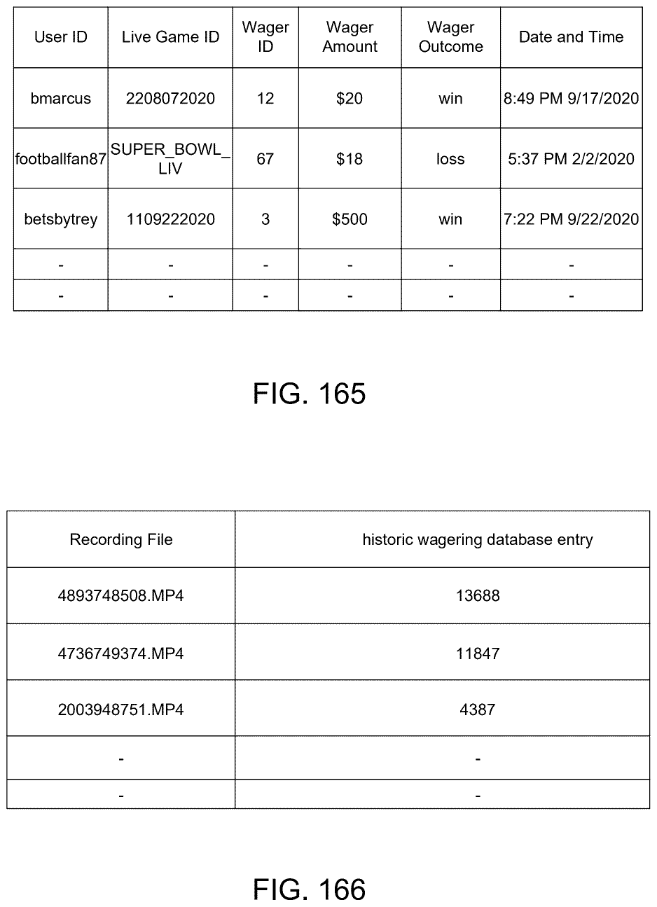

FIG. 165 illustrates a historical wagering database, according to an embodiment.

FIG. 166 illustrates a recording database, according to an embodiment.

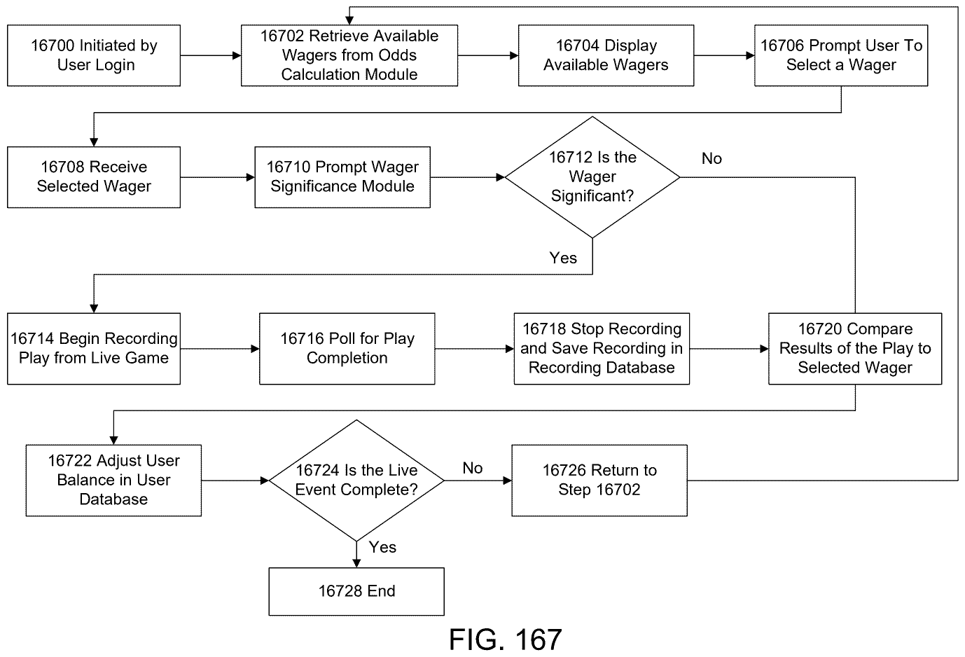

FIG. 167 illustrates a base wagering module, according to an embodiment.

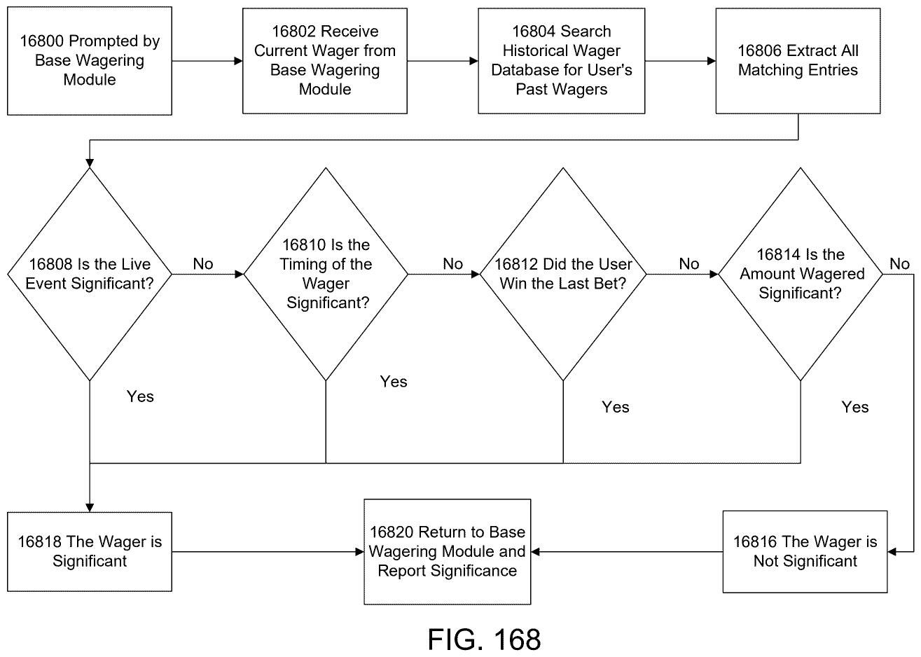

FIG. 168 illustrates a wager significance module, according to an embodiment.

FIG. 164 is a system for wagering. This system may include a live event 16402, for example a sporting event such as a football game, basketball game, baseball game, hockey game, tennis match, golf tournament, eSports or digital game, etc. The live event 16402 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event, such as the score of American football or the run line in baseball, or a series of action in the live event. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events 16402 in the future. Sportsbooks need to offer payment processing services in order to cash out customers. This can be done at kiosks at the live event or at another location.

Further, embodiments may include a plurality of sensors 16404 that may be used such as motion sensors, temperature sensors, humidity sensors, cameras such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 16406 or communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the Internet and relies on sharing of resources to achieve coherence and economics of scale, like a public utility, while third-party clouds allow organizations to focus on their core businesses instead of expending resources on computer infrastructure and maintenance. The cloud 16406 may be communicatively coupled to wagering network 16408 which may perform real time analysis on the type of play and the result of the play. The cloud 16406 may also be synchronized with game situational data, such as the time of the game, the score, location on the field, weather conditions, and the like which may affect the choice of play utilized. For example, in other exemplary embodiments, the cloud may not receive data gathered from sensors 16404 and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various exemplary embodiments herein.

Further, embodiments may include a wagering network 16408 which may perform real time analysis on the type of play and the result of a play or action. The wagering network 16408 (or cloud 16406) may also be synchronized with game situational data, such as the time of the game, the score, location on the field, weather conditions, and the like which may affect the choice of play utilized. For example, in other exemplary embodiments, wagering network 16408 may not receive data gathered from sensors 16404 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein. The wagering network can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may include a user database 16410 which contains data relevant to all users of the system, which may include, a user ID of the user, a device identifier for their mobile device 16426, a list of the players indicated as favorites by the user through the favorites module 16420, and could also include wagering history on the user, and other relevant user data.

Further, embodiments may include an odds calculation module 16412 which utilizes historical play data to calculate odds for in-play wagers.

Further, embodiments may include historical plays database 16414, that contains play data for the type of sport being played in live event 16402. For example, in American football for optimal odds calculation, the historical play data should include meta data about the historical plays, such as time, location, weather, previous plays, opponent, physiological data, etc.

Further, embodiments may include an odds database 16416 that contains the odds calculated by the odds calculation module to display the odds the user's mobile device 16426 and to take bets from the user through the mobile device wagering app 16428.

Further, embodiments may include a historical wagering database 16418 that contains data on wagers made by users in the past via the wagering app 16428. For example, the database may include the amount wagered, the time of the wager, the type of sporting event or play wagered on, the odds of each wager selection, during which live event 16402 the wager was made, etc.

Further, embodiments may include a recording database 16420 that contains media recordings associated with significant wagers, for example, if a wager significance module 16424 determines that a wager is significant, then the recording database 16420 may contain a media recording of the live event 16402 at the time of the wager, the user's reaction to making the wager, the user's reaction to the results of the wager, some other event related to the wager, or any combination of multiple media recordings.

Further, embodiments may include a base wagering module 16422 that allows the user to log into the wagering network 16408, view the selectable wagers, and make a wager, then the base wagering module 16422 prompt the wagering significance module 16424 to determine if the wager is significant, and if so begins to record the play from the live event 16402 (or otherwise denote time of video that is significant), the wager data is stored in the historical wagering database 16418 and the recording is stored in the recording database 16420.

Further, embodiments may include a wager significance module 16424 that determines if a wager meets the criteria to be considered significant, for example, a wager that is higher than any other the user has ever made is significant, a wager on a high-profile live event 16402 such as a world championship is significant, a wager made after a streak of losses or wins is significant, etc.

Further, embodiments may include a mobile device 16426 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allow for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a Fire Wire bus, an Ethernet bus, a Gigabit Ethernet bus, a Fiber Channel bus, or a Thunderbolt bus. In some embodiments the mobile device 16426 could be an optional component and would be utilized in a situation in which a paired wearable device is utilizing the mobile device 16426 as additional memory or computing power or connection to the internet.

Further, embodiments may include a wagering app 16428, which is a program that enables the user to place bets on individual plays in the live event 16402, and display the audio and video from the live event 16402, along with the available wagers on the mobile device 16426. The wagering app 16428 allows the user to interact with the wagering network 108 in order to place bets and provide payment/receive funds based on wager outcomes.

FIG. 165 illustrates the historical wagering database 16418 which contains data on wagers made by users in the past via the wagering app 16428. This data includes a user ID, for example, “bmarcus”, a live game ID, for example, “2208072020”, a wager ID, for example, “12”, the amount wagered, for example, “$20”, the outcome of the wager, for example, “win”, and the time and date of the wager, for example, “8:49 PM Sep. 17, 2020”, in some embodiments additional data may be contained in the historical wagering database 16418.

FIG. 166 illustrates the recording database 16420 which contains media recordings associated with significant wagers, for example, if the wager significance module 16424 determines that a wager is significant, then the recording database 16420 may contain a media recording of the live event 16402 at the time of the wager, the user's reaction to making the wager, the user's reaction to the results of the wager, some other event related to the wager, or any combination of multiple media recordings. The database contains the recording file, for example, “4893748508.MP4”, and the number of the associated entry in the historical wager database 16418, for example, “13688”, in some embodiments the database may contain additional data.

FIG. 167 illustrates the base wagering module 16422. The process begins with the base wagering module 16422 being, at step 16700, initiated by user login via the wagering app 16428, login includes at least a user ID, in some embodiments login may include security credentials such as a password. For example, user Brandon Marcus is watching a football game and logins in with his username “bmarcus” in order to make wagers. The base wagering module 16422 retrieves, at step 16702, the available wagers for the current play of the live event 16402 from the odds calculation module 16412, in an embodiment wagers and odds may be retrieved from a third party. The base wagering module 16422 displays, at step 16704, the available wagers for the current play and the associated odds for each wager. The base wagering module 16422 prompts, at step 16706, the user to select one of the available wagers, in an embodiment this selection process may be facilitated by a GUI within the wagering app 16428. The base wagering module 16422 receives, at step 16708, the user's selection of wager for the current play and the amount of money the user has wagered. For example, user Brandon Marcus is sure the next play is going to be a pass, he selects the wager option for “pass” and wagers $20. The base wagering module 16422 prompts, at step 16710, the wager significance module 16424 with the collected data in order to determine if the wager is considered significant. The base wagering module 16422 receives, at step 16712, a determination from the wager significance module 16424 on whether the wager is considered significant. If the wager is not significant, the base wagering module 16422 skips to step 16720. If the wager is significant, the base wagering module 16422 begins, at step 16714, recording the current play of the live event 16402, in an embodiment the base wagering module may also begin recording the user via the mobile device 16426. Further, upon the beginning or initiation of a recording, some indicia, such as a message or light which indicates a recording is being made, may be provided. The base wagering module 16422 polls, at step 16716, for completion of the current play of the live event 16402. The base wagering module 16422 stops, at step 16718, recording the play once the play is completed and stores the recording in the recording database 16420. Further, at this time, the indicia that a recording was being made may be removed or a message indicating that a recording has ended may be provided. The base wagering module 16422 compares, at step 16720, the actual results of the play of the live event 16402 to the user's wager selection. For example, if user Brandon Marcus wagered that the next play would be a pass, and the play was in fact a pass, then the user won the wager. The base wagering module 16422 adjusts, at step 16722, the user's balance in the user database 16410 based on whether the wager was won or lost, in an embodiment a third party will instead handle user balance and payments. The base wagering module 16422 determines, at step 16724, if the live event 16402 is complete via data from the sensor feeds 16404, in some embodiments the end of the live event may be manually determined or determined by another module. If the live event 16402 is not complete, the base wagering module 16422 returns, at step 16724, to step 16702. If the live event 16402 is complete, the base wagering module 16422 ends, at step 16728.

In further embodiments, it may be understood that the making or generating of a recording may not be performed and, instead, a video file which has already been created and may be stored in a database or otherwise linked, may be utilized in any of the embodiments. For example, a video file stored in another database may have utilize timestamps associated with a beginning and end of a play. Further, any polling or determining of a start and end portion of a play may be done without a new recording being generated, locally or otherwise.

FIG. 168 illustrates the wager significance module 16424. The process begins with the wager significance module 16424 being, at step 16800, prompted by the base wagering module 16422. The wager significance module 16424 receives, at step 16802, the current wager from the base wagering module 16422. For example, if user Brandon Marcus has made a wager that the next play will be a pass and has wagered $20, the wager significance module 16424 will receive the ID of the live event 16402 and play being wagered on, the wager option which is “pass”, the user's ID which is “bmarcus”, and the wager amount which is $20. The wager significance module 16424 searches, at step 16804, the historical wagering database 16418 for entries that match the user ID of the logged-in user. The wager significance module 16424 extracts, at step 16806, the entries in the historical wagering database 16418 that match the user ID of the logged-in user. The wager significance module 16424 determines, at step 16808, if the live event 16402 is significant, a significant live event 16402 would be a national or world championship, for example, the Super Bowl, or World Cup, in some embodiments these live events 16402 may be compared to a database of significant live events in order to determine significance, in another embodiment significant live events 16402 may have a different naming convention that indicates significance. In another embodiment the live event 16402 may by significant if it involves the user's preferred player(s) or team(s). If the live event 16402 is significant, the wager significance module 16424 skips to step 16818. For example, if user Brandon Marcus is watching an insignificant live event 16402 then none of the wagers he makes during the game will determined to be significant at this step. The wager significance module 16424 determines, at step 16810, if the timing of the wager is significant by checking if this is the first wager made by the user during the live event 16402, in some embodiments other timings may be considered significant, for example, the first bet after half time, the first bet of the season, a bet made within overtime, the last possible bet of the game, etc. If the timing of the wager is significant, the wager significance module 16424 skips to step 16818. For example, user Brandon Marcus makes two wagers during the football game he is watching, the first wager is made on the opening play of the game, the second wager is made on the 8th play of the game. The wager significance module would determine that the wager made on the first play is significant, while the wager made on the 8th play of the game is not significant at this step. The wager significance module 16424 determines, at step 16812, if the user won their last bet by searching for the extracted entry that is the most recent in time, in some embodiments a streak of wins or losses may be required to find a new wager is significant. If the user won their last bet, the wager significance module 16424 skips to step 16818. For example, user Brandon Marcus makes two wagers during the football game he is watching, the first wager is made on the opening play of the game, the second wager is made on the 8th play of the game. The wager significance module would determine that neither wager is significant because at least 3 wagers are required for a win or loss streak. The wager significance module 16424 determines, at step 16814, if the amount wagered is significant by checking if the current wager is the largest amount in the user's history, in some embodiments more than the maximum amount will be considered significant, for example, the top 10 amounts wagered, any wager above average, any wager above $100, any wager one standard deviation above average, etc. If the amount wagered is significant, the wager significance module 16424 skips to step 16818. For example, user Brandon Marcus makes two wagers during the football game he is watching, the first wager is made on the opening play of the game and, the second wager is made on the 8th play of the game. The first wager was for $20, and the second wager was for $5. User Brandon Markus rarely wagers more than $10, in fact his highest wager of all time was only $18. The wager significance module would determine that the wager made on the first play is significant, while the wager made on the 8th play of the game is not significant at this step. If none of the preceding criteria were met, the wager significance module 16424 denotes, at step 16816, that the wager is not significant, in some embodiments there may be more, less, or different criteria to determine significance. For example, user Brandon Marcus's second wager was not determined to be significant in steps 16808, 16810, 16812, nor 16814, therefore the second wager is not significant. If any of the preceding criteria were met, the wager significance module 16424 denotes, at step 16818, that the wager is significant, in some embodiments there may be more, less, or different criteria to determine significance. For example, user Brandon Marcus's first wager was determined to be significant in steps 16810 and 16814, therefore the first wager is significant. The wager significance module 16424 returns, at step 16820, to the base wagering module along with the determination on whether the wager was significant. Additionally, at this time or at any other time when a wager is determined to be significant, some indicia, such as a notification, audio notification, visual indicia, such as a red light, or other indicia may be provided to indicate that a wager is significant.

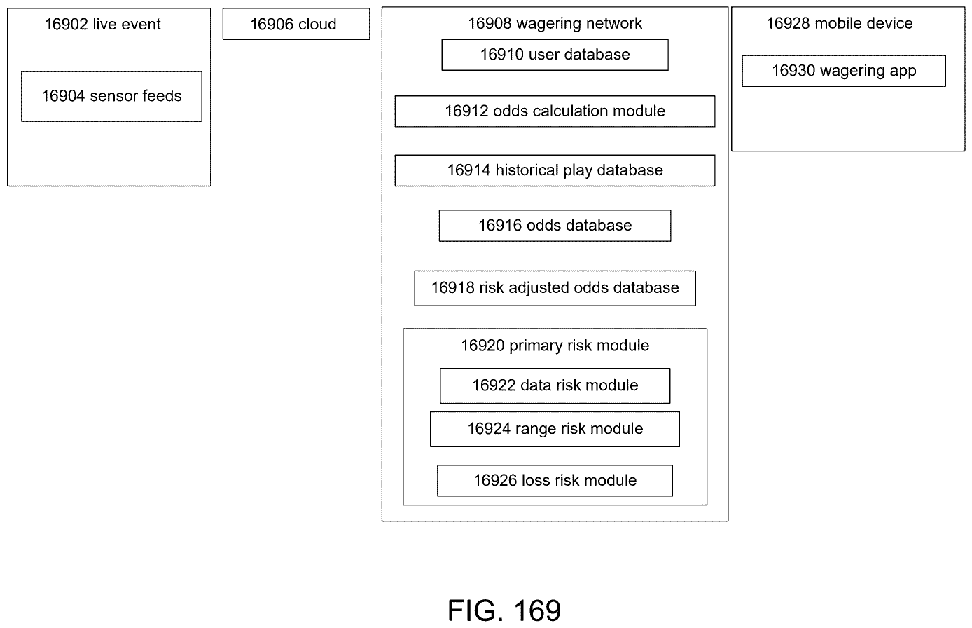

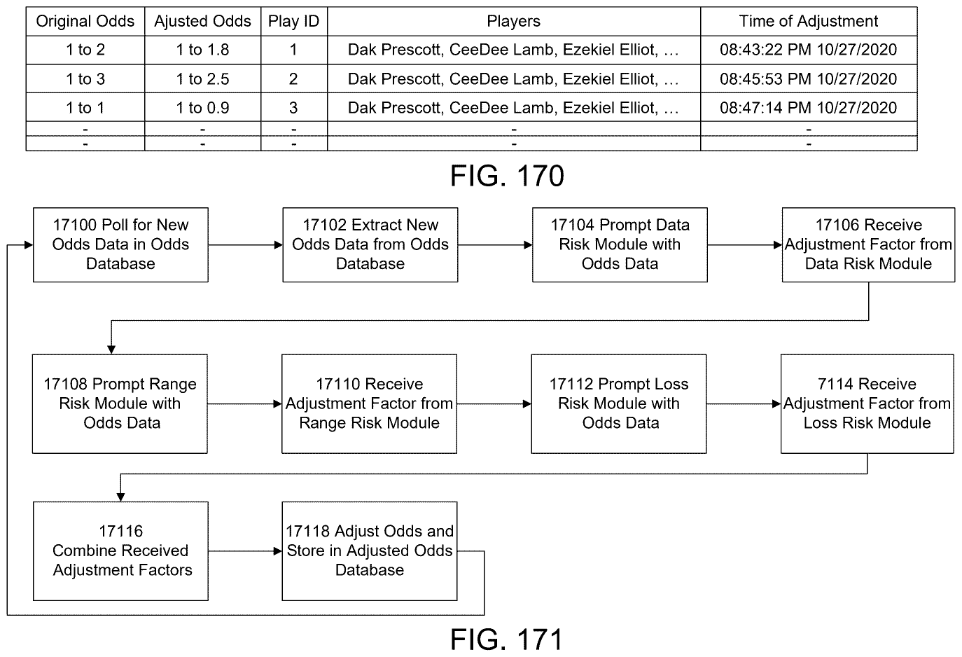

FIG. 169 illustrates a system for a player focused wagering system, according to an embodiment.

FIG. 170 illustrates a risk adjusted odds database, according to an embodiment.

FIG. 171 illustrates a primary risk module, according to an embodiment.

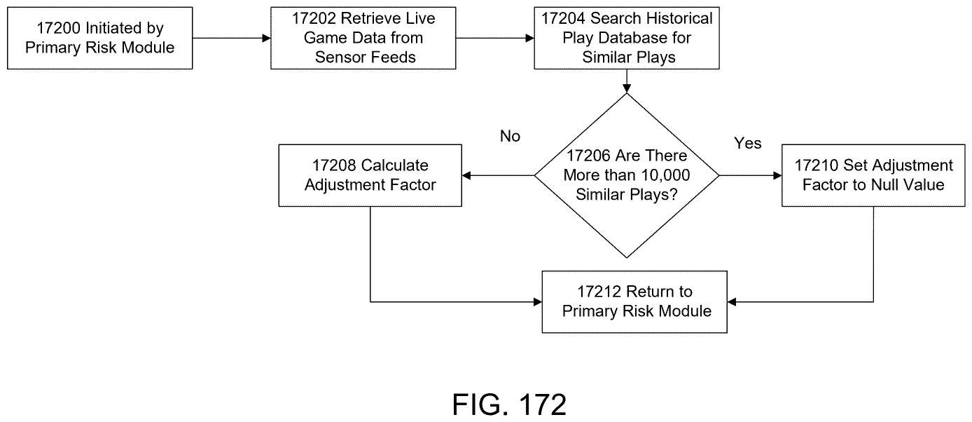

FIG. 172 illustrates a data risk module, according to an embodiment.

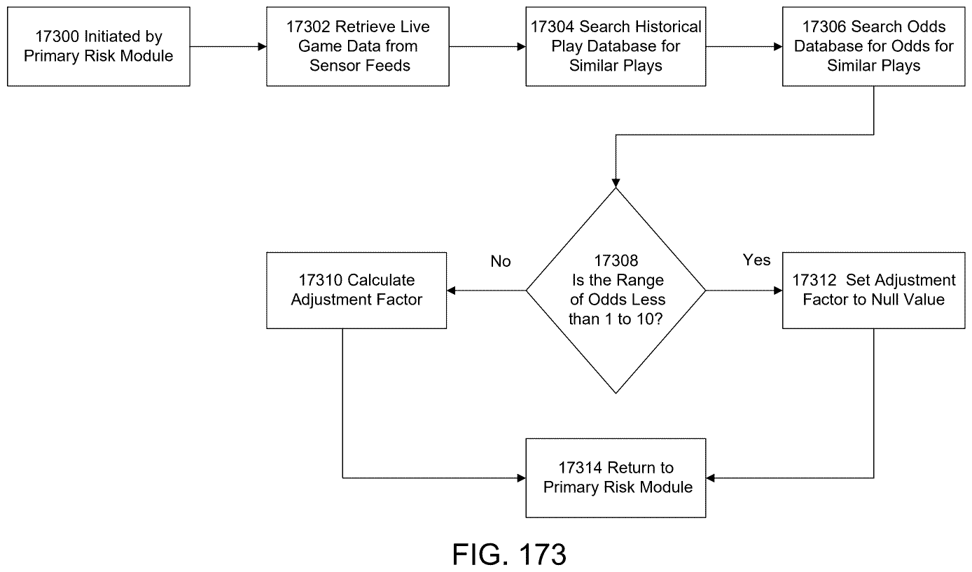

FIG. 173 illustrates a range risk module, according to an embodiment.

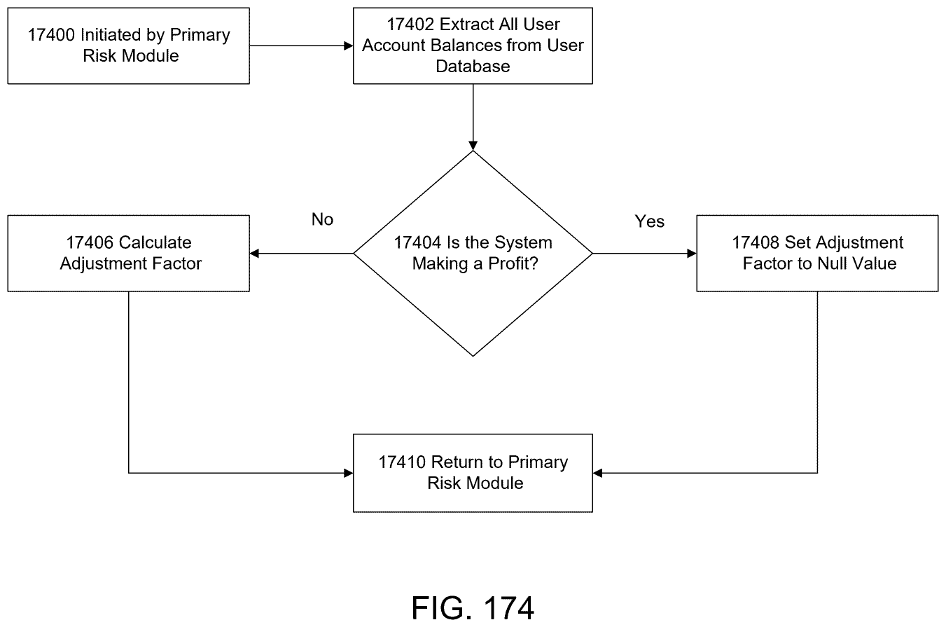

FIG. 174 illustrates a loss risk module, according to an embodiment.

FIG. 169 is a system for a player focused wagering system. This system may include a live event 16902, for example a sporting event such as a football game, basketball game, baseball game, hockey game, tennis match, golf tournament, eSports or digital game, etc. The live event 16902 will include some number of actions or plays, upon which a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 16902, such as the score of American football or the run line in baseball, or a series of action in the live event 16902. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events 16902 in the future. Sportsbooks need to offer payment processing services in order to cash out customers. This can be done at kiosks at the live event 16902 or at another location.

Further, embodiments may include a plurality of sensors 16904 that may be used such as motion sensors, temperature sensors, humidity sensors, cameras such as an RGB-D camera which is a digital camera capable of capturing color (RGB) and depth information for every pixel in an image, microphones, a radiofrequency receiver, a thermal imager, a radar device, a lidar device, an ultrasound device, a speaker, wearable devices etc. Also, the plurality of sensors 16904 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 16906 or communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, which may occur over the Internet and relies on sharing of resources to achieve coherence and economies of scale, like a public utility, while third-party clouds allow organizations to focus on their core businesses instead of expending resources on computer infrastructure and maintenance. The cloud 106 may be communicatively coupled to a wagering network 16908 which may perform real time analysis on the type of play and the result of the play. The cloud 16906 may also be synchronized with game situational data, such as the time of the game, the score, location on the field, weather conditions, and the like which may affect the choice of play utilized. For example, in an exemplary embodiment, the cloud 16906 may not receive data gathered from the plurality of sensors 16904 and may, instead, receive data from an alternative data feed, such as Sports Radar®. This data may be compiled substantially immediately following the completion of any play and the data from this feed may be compared with a variety of team data and league data based on a variety of elements, including down, possession, score, time, team, and so forth, as described in various exemplary embodiments herein.

Further, embodiments may include the wagering network 16908 which may perform real time analysis on the type of play and the result of a play or action. The wagering network 16908 (or cloud 16906) may also be synchronized with game situational data, such as the time of the game, the score, location on the field, weather conditions, and the like which may affect the choice of play utilized. For example, in an exemplary embodiment, the wagering network 16908 may not receive data gathered from the plurality of sensors 16904 and may, instead, receive data from an alternative data feed, such as Sports Radar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 16908 may offer any number of software as a service managed services such as, user interface service, risk management service, compliance, pricing and trading service, IT support of the technology platform, business applications, game configuration, state based integration, fantasy sports connection, integration to allow the joining of social media, and marketing support services that can deliver engaging promotions to the user.

Further, embodiments may include a user database 16910 which contains data relevant to all users of the system, and may include any of, a user ID of the user, a device identifier for their mobile device 16928, a list of the players indicated as favorites by the user, and could also include wagering history on the user, and other relevant user data. Further, embodiments may include an odds calculation module 16912 which utilizes historical play data to calculate odds for in-play wagers.

Further, embodiments may include a historical plays database 16914, that contains play data for the type of sport being played in live event 16902. For example, in American football for optimal odds calculation, the historical play data may include meta data about the historical plays, such as time, location, weather, previous plays, opponent, physiological data, etc.

Further, embodiments may include an odds database 16916 that contains the odds calculated by the odds calculation module to display the odds to the user's mobile device 16928 and to take bets from the user through a mobile device wagering app 16930.

Further, embodiments may include a risk adjusted odds database 16918 which stores the original odds from odds database 16916 as well as the risk adjusted odds. The database may store any of plays, the players of plays, odds given, and a time stamp for when the odds have been risk adjusted.

Further, embodiments may include a primary risk module 16920 which coordinates any of related specific risk modules. By coordination, this module will determine play by play which specific risk modules to use. This is accomplished by each specific risk module analyzing the current play and returning a risk adjustment to the odds. If several specific risk modules return odds adjustment, this primary risk module 16920 would determine final risk, by any of a number of means, for instance it could (1) select the lowest risk returned, (2) calculate and then use the mean of the adjusted risk scores, etc. If more than one risk is returned, the primary risk module 16920 would determine the range of risks and may, for example, create the average of the risk and use this average to determine if the odds needs to be adjusted. The primary risk module 16920 could use the highest risk of multiple risks and this highest risk would be used to determine if the odds needs to be adjusted. The primary risk module 16920 also allows for executing specific risk modules that can be executed in various places on the cloud, such as but not limited to (1) an integrated module in the wager network, (2) a 3rd party module that is called by the wager network 16908, (3) a plurality of 3rd party modules where multiple risks can be evaluated, a (4) hybrid of integrated module and 3rd part modules. Of course, it is understood, if the specific risk modules is not on the wagering network 16908 itself, adequate data from the wagering network 16908 would be made available (thru API's) to the specific risk modules not on the wager network.

Further, embodiments may include a data risk module 16922 which first checks the weather this module is needed. This is done by looking at the bet on a play and determining how many times this bet has been played at the current odds. If there is a significant amount of data in the data base, say >10,000 bets, this module returns “no change to the odds” however, this module may find, for instance, that if f odds are calculated for <10,000 bets but say >5,000 bets, there is more risk associated with the bet, so the odds are changed and may move form 2:1 to 3:1. If for instance there is even far less data that was used, say <5,000 bets to >1000 bets, there is even more risk associated with the bet, so the odds are changed and may move say 2:1 to 5:1. If there are less than 1000 bets, a “lock” is returned in than a bet is not offered. The actual number of datapoints ranges and odds adjustment can be predefined or this could be calculated in real time. They can be predefined by evaluating historical data of related bets and data points and ranges of adjustment of bets. They can be calculated in real time by changing the risk adjustment up or down based upon data points and the results can then be used to continue to look at data point ranges and adjustments to get closer to having odds that benefit the profit of the system.

Further, embodiments may include a range risk module 16924 which first checks whether this module is needed. This is done by looking at the bet on a play and determining how the range of bets of the play, for example 2:1 to 2.5:1 or 2:1 to 10:1. If there is a significant amount of range in the data base, say <. 5:1 odds change, this module returns “no change to the odds”. However, this module may find, for instance, that if the odds are calculated for 2:1 to 5:1, there is more risk associated with the bet, so the odds are changed and may move to, for instance 3.5:1 (which is the midpoint of 2:1 and 5:1). If for instance there is even far great odds changes found, for instance 2:1 to 10:1 range, there is even more risk associated with the bet, so the odds are changed and may move say 2:1 to 6:1 which is above the midpoint. If there are large ranges, say 2:1 to >10:1 in odds, a “lock” is returned so that a bet is not offered. The actual ranges and odds adjustment can be predefined, or they could be calculated in real time. They can be predefined by evaluating historical data of related bets and ranges of bets. They can be calculated in real time by slowly changing the risk adjustment up or down based upon ranges of odds of a bet and then using the results to continue to look at data point ranges and adjustments to get closer to having odds that benefit the profit of the system.

Further, embodiments may include a loss risk module 16926 which first checks whether this module is needed. This is done by looking at average wins and losses of all betters and determining the amount of loss per unit time of per amounts of bets is acceptable. For example, if the system is currently running a profit, this module will return a “no change in odds” If however, the system is currently losing $100,000 and the loss is increasing at $5,000 per play, this is an significant amount of loss in the data base, and so all odds will be adjusted to lower their risk, for example change the odds by 10% to lower risk. However, this module may find, for instance, that there is more significant loss, at $250,000 and the loss is increasing at $10,000 per play. This is a very significant amount of loss in the data base, and so all odds will be adjusted to lower their risk, for example change the odds by 30% to lower risk. If there is even more loss that system may send a “lock” to certain high odds bets in general. The actual losses and rates of loses can be predefined or they could be calculated in real time. They can be predefined by evaluating historical data of related bets and ranges of loses. They can be calculated in real time by slowly changing the risk adjustment up or down based upon loses and then results are used over to continue look at loses and adjustments are made to get closer to having odds that benefit the profit of the system.

Further, embodiments may include the mobile device 16928 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allows for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 16928 could be an optional component and would be utilized in a situation in which a paired wearable device is utilizing the mobile device 16928 as additional memory or computing power or connection to the internet.

Further, embodiments may include the wagering app 16930, which is a program that enables the user to place bets on individual plays in the live event 16902, and display the audio and video from the live event 16902, along with the available wagers on the mobile device 16928. The wagering app 16930 allows the user to interact with the wagering network 16908 in order to place bets and provide payment/receive funds based on wager outcomes.

FIG. 170 illustrates the risk adjusted odds database 16918. The risk adjusted odds database 16918 contains the original odds from odds database 16916 as well as the risk adjusted odds. The database contains a play ID, for example, 1, all players involved in the play, for example “Dak Prescott”, “CeeDee Lamb” “Ezekiel Elliot”, etc. and, a time stamp for when the odds have been risked adjusted, for example, 8:43:22 PM Oct. 27, 2020. In some embodiments the database may contain additional data on the conditions of the play such as weather, game time, teams, etc.

FIG. 171 illustrates the primary risk module 16920. The process begins with the primary risk module 16920 polling, at step 17100, for new odds data in the odds database 16916. The primary risk module 17020 extracts, at step 17102, the new odds data in the odds database 16916; in some embodiments the primary risk module may also obtain data from the sensor feeds 16904. The primary risk module 16920 prompts, at step 17104, the data risk module 16922 with the extracted odds data. The primary risk module 16920 receives, at step 17106, an adjustment factor from the data risk module 16922. In this example the adjustment factor is in the form of a percentage to adjust the odds down so as to lessen the risk to the wagering network 16908. This percentage adjustment is larger the more uncertainty there is about the outcome, as calculated by the data risk module 16922, the range risk module 16924, and the loss risk module 16926. The primary risk module 16920 prompts, at step 17108, the range risk module 16924 with the extracted odds data. The primary risk module 16920 receives, at step 17110, an adjustment factor from the range risk module 16924. The primary risk module 16920 prompts, at step 17112, the loss risk module 16926 with the extracted odds data. The primary risk module 16920 receives, at step 17114, an adjustment factor from the data risk module 16926. The primary risk module 16920 combines, at step 17116, the received adjustment factors by averaging the factors. In some embodiments the factors may be combined by other methods such as selecting the smallest factor, selecting the largest factor, multiplying the factors together, etc. The primary risk module 16920 adjusts, at step 17118, the odds based on the combined adjustment factor, for example if the odds from the odds calculation module 16912 were originally 1 to 2 and the combined risk adjustment factor is 0.9 then the odds will be adjusted by multiplying the payout by 0.9, yielding odds of 1 to 1.8, the adjusted odds are then stored in the risk adjusted odds database 16918 and the primary risk module 17020 returns to polling for new odds data in the odds database 17016. It should be obvious that these risk factors are not the only risk factors that could be considered, and that they could be used individually or in different combinations. The different risk factors could be weighted differently, and all of these variables could change based on the context of the live event 16902 and/or the wagering activity on the wagering network 16908.

FIG. 172 illustrates the data risk module 16922. The process begins with the data risk module 1692 being, at step 17200, initiated by the primary risk module 16920. The data risk module 16922 retrieves, at step 17202, data on the current state of the live event 16902 from the sensor feed of the plurality of sensors 16904; for example the live event 16902 features the Dallas Cowboys against the Cleveland Browns, Dallas is on offence, it is 2nd and 7 yards and 3 minutes into the second quarter, and the weather is sunny with 5 mph winds. The data risk module 16922 searches, at step 17204, the historical play database 16914 for plays that are similar to the current state of the live event 16902, similar does not mean exact, some parameters may be within a range of values and not all parameters must be similar for a play to be similar, for example the live event 16902 features the Dallas Cowboys against the Cleveland Browns, Dallas is on offence, its is 2nd and 7 yards and 3 minutes into the second quarter, and the weather is sunny with 5 mph winds, a similar play may be one wherein the Dallas Cowboys played against the Cleveland Browns, Dallas was on offence, it was 2nd and 5 yards and 6 minutes into the second quarter, and the weather was sunny with no wind. In some embodiments the criteria for a similar play may be dynamic. The data risk module 16922 determines, at step 17206, if there are more than 10,000 similar plays stored in the historical play database 16914, in other embodiments the number may be a different number than 10,000, in some embodiments this number may be set dynamically. If there are less than 10,000 similar plays, the data risk module 16922 calculates, at step 17208, an adjustment factor based on the amount of results, if the results are between 10,000 and 5,000 the factor is 0.9, if the number is less than 5,000 the factor is 0.8. For example, the live event 16902 features the Dallas Cowboys against the Cleveland Browns, Dallas is on offence, it is 2nd and 7 yards and 3 minutes into the second quarter, and the weather is sunny with 5 mph winds, there are 4000 plays in the historical play database 16914 which are similar to the current play of the live event 16902, since 4000 is less than 5000 the adjustment factor for wagers made on the current play is 0.8. In other embodiments the adjustment factor may be calculated by other methods, for example, multiplying the number of results by 0.0001. It should be obvious that these thresholds could be based on other factors besides the number of bets placed on similar plays in the past; for example, the amount of money wagered on a similar play in the past, or the winning percentage of users on similar plays in the past. Additionally, how the system identifies a similar play could be done based on characteristics of the live event 16902, such as the down and distance, team, weather, etc., as it is in this embodiment, but it could also be done based on the nature of the wagers placed on that play or characteristics of the users who have placed bets on the play. If there are more than 10,000 similar plays, the data risk module 16922 sets, at step 17210, the adjustment factor to a null value, in some embodiments this may be achieved by simply setting the adjustment factor to 1. The data risk module 16922 returns, at step 17212, to the primary risk module 16920 with the adjustment factor.

FIG. 173 illustrates the range risk module 16924. The process begins with the range risk module 16924 being, at step 17300, initiated by the primary risk module 16920. The range risk module 16924 retrieves, at step 17302, data on the current state of the live event 16902 from the sensor feed of the plurality of sensors 16904, for example the live event 16902 features the Dallas Cowboys against the Cleveland Browns, Dallas is on offence, it is 2nd and 7 yards and 3 minutes into the second quarter, and the weather is sunny with 5 mph winds. The range risk module 16924 searches, at step 17304, the historical play database 16914 for plays that are similar to the current state of the live event 16902, similar does not mean exact, some parameters may be within a range of values and not all parameters must be similar for a play to be similar, for example the live event 16902 features the Dallas Cowboys against the Cleveland Browns, Dallas is on offence, it is 2nd and 7 yards and 3 minutes into the second quarter, and the weather is sunny with 5 mph winds, a similar play may be one wherein the Dallas Cowboys played against the Cleveland Browns, Dallas was on offence, it was 2nd and 5 yards and 6 minutes into the second quarter, and the weather was sunny with no wind. In some embodiments the criteria for a similar play may be dynamic. The range risk module 16924 searches, at step 17306, the odds database 16916 for the corresponding odds to each of the similar plays found in the historical play database 16914. The range risk module 16924 determines, at step 17308, if the range of odds for all of the similar plays is less than 1 to 10, for example if the lowest odds for a similar play is 1 to 1 and the highest is 1 to 9 then the range is 1 to 8, this can be expressed more clearly in percentages, 1 to 1 is a 100% return on wager 1 to 9 is a 900% return on wager and therefore the range is 800% return on wager and less than 1 to 10 or 1000%. If the lowest odds for a similar play is 2 to 1 and the highest is 1 to 12 then the range would be greater than 1 to 10. If the range of odds for all of the similar plays is more than 1 to 10, the range risk module 16924 calculates, at step 17310, an adjustment factor based on the range of odds, if the range of odds are between 1 to 10 and 1 to 15 the factor is 0.9, if the range of odds is more than 1 to 15 the factor is 0.8. For example, the live event 16902 features the Dallas Cowboys against the Cleveland Browns, Dallas is on offence, it is 2nd and 7 yards and 3 minutes into the second quarter, and the weather is sunny with 5 mph winds, there are 10,000 plays in the historical play database 16914 which are similar to the current play of the live event 16902, each similar play has a number of wager options which each have their own individual odds, the lowest odds on one of the similar plays is 2 to 1 and the highest odds on another one of the similar plays is 1 to 20, since the range of odds is more than 1 to 15 the adjustment factor for wagers on the current play is 0.8. It should be obvious that these thresholds could be based on other factors besides the odds of bets placed on similar plays in the past; for example, the amount of money wagered on a similar play in the past, or the winning percentage of users on similar plays in the past. Additionally, how the system identifies a similar play could be done based on characteristics of the live event 16902, such as the down and distance, team, weather, etc., as it is in this embodiment, but it could also be done based on the nature of the wagers placed on that play or characteristics of the users who have placed bets on the play. In other embodiments the adjustment factor may be calculated by other methods, for example, dividing 10 by the range of odds expressed as a whole number, for example, if the range of odds is 1 to 20, then the factor would be 10/20 or 0.5. If the range of odds for all of the similar plays is less than 1 to 10, the range risk module 16924 sets, at step 17312, the adjustment factor to a null value, in some embodiments this may be achieved by simply setting the adjustment factor to 1. The range risk module 16924 returns, at step 17314, to the primary risk module 16920 with the adjustment factor.

FIG. 174 illustrates the loss risk module 16926. The process begins with the loss risk module 16926 being, at step 17400, initiated by the primary risk module 16920. The loss risk module 16926 searches, at step 17402, the user database 16910 for all user account balances, in some embodiments the loss risk module 16926 will only search for changes to account balances within a set time frame for example, the last day, since the start of the current live event 16902, the last 10 plays, etc. In other embodiments the loss risk module 126 may retrieve the total net losses or gains of the system from another source or database. The loss risk module 16926 determines, at step 17404, if the system is making a profit by determining the net gain across all user account balances, if the net gain is positive then the system is losing money, if the net gain is negative then the system is gaining money and therefore making a profit. In some embodiments the loss risk module 16926 may consider costs from other sources such as employee pay, maintenance costs of the system, credit given freely to users, royalties, etc. If the system is not profitable, the loss risk module 16926 calculates, at step 17406, an adjustment factor based on the total amount of loss, if the net loss less than $5,000 the factor is 0.9, if the net loss is more than 5,000 the factor is 0.8. For example, the live event 16902 features the Dallas Cowboys against the Cleveland Browns, Dallas is on offence, it is 2nd and 7 yards and 3 minutes into the second quarter, and the weather is sunny with 5 mph winds, since the beginning of the live event 16902 the system has lost a net $3,000, since $3,000 is less than $5,000 the adjustment factor for wagers made on the current play is 0.9. It should be obvious that these thresholds could be based on other factors besides total net loss. For example, the amount of difference between actual and expected revenue or the net change in profit from one play to the next. Additionally, how the system identifies a similar play could be done based on characteristics of the live event 16902, such as the down and distance, team, weather, etc., as it is in this embodiment, but it could also be done based on the nature of the wagers placed on that play or characteristics of the users who have placed bets on the play. In some embodiments the adjustment factor may calculated based on the required amount of adjustment to turn the system profitable, for example if the net loss is 10% of the total money wagered then setting the adjustment factor to 0.9 or lower would be expected to turn the system profitable. If the system is profitable, the loss risk module 16926 sets, at step 17408, the adjustment factor to a null value, in some embodiments this may be achieved by simply setting the adjustment factor to 1. The loss risk module 16926 returns, at step 17410, to the primary risk module 16920 with the adjustment factor.

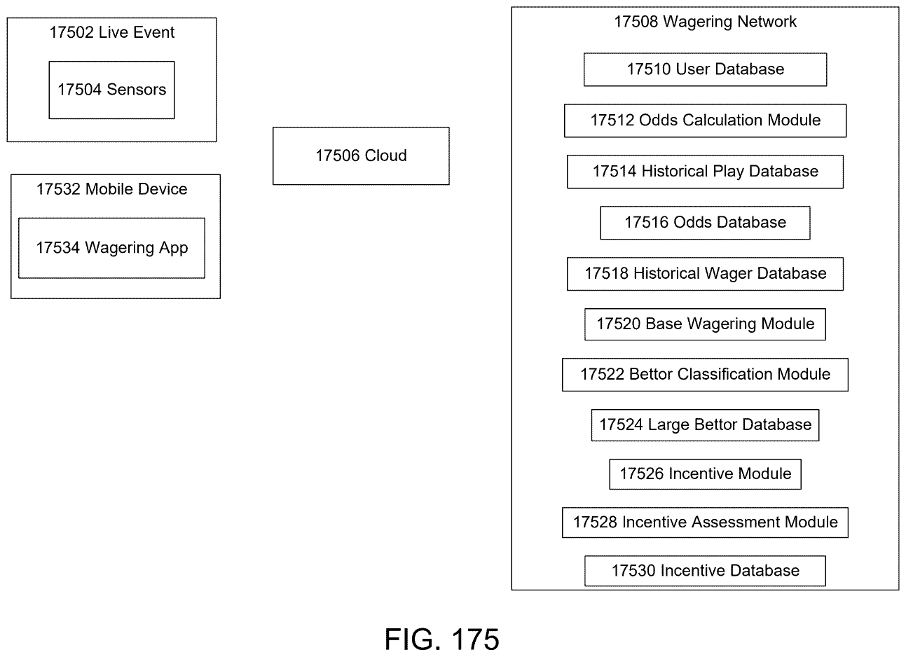

FIG. 175 illustrates a system for a wager reward method, according to an embodiment.

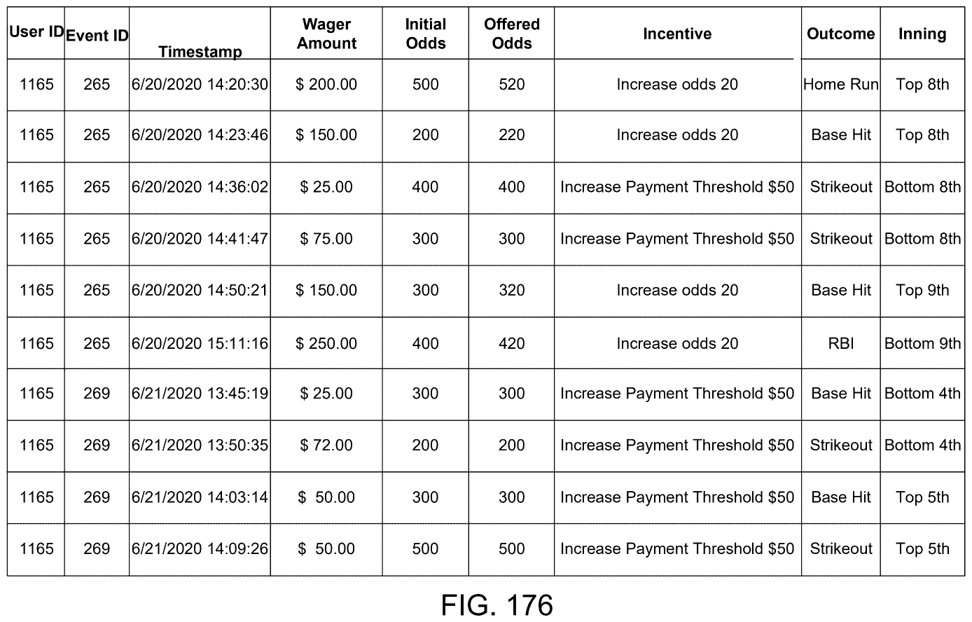

FIG. 176 illustrates a historical wager database, according to an embodiment.

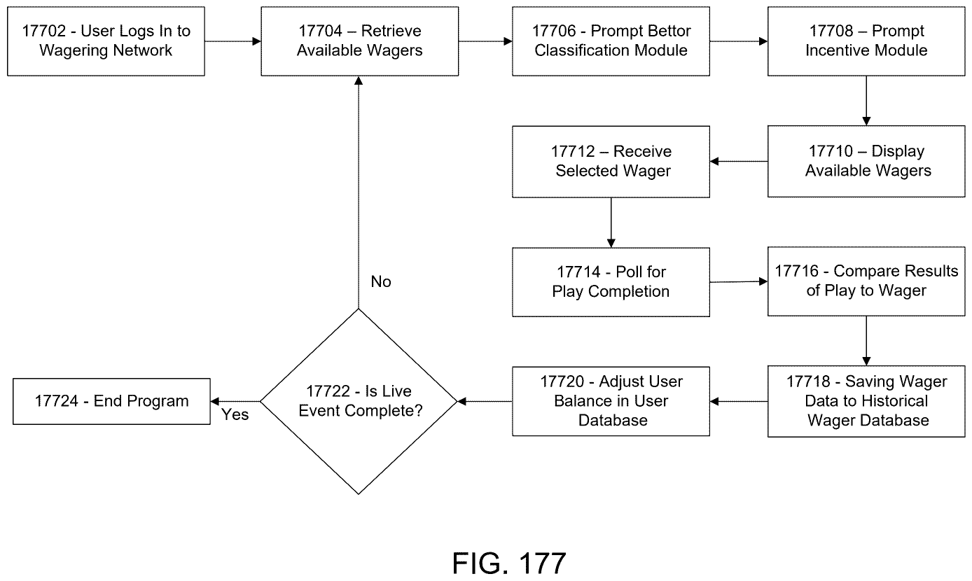

FIG. 177 illustrates a base wagering module, according to an embodiment.

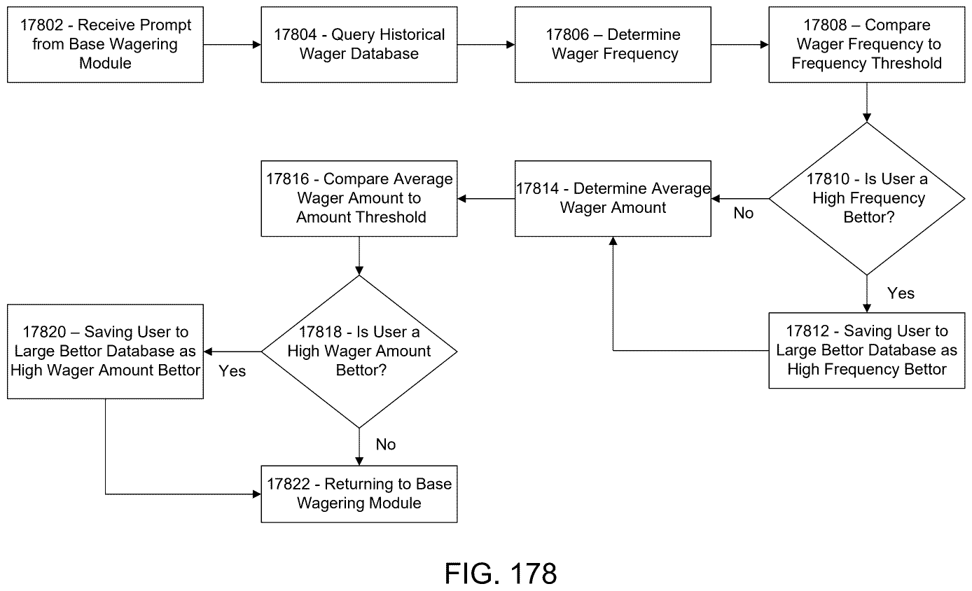

FIG. 178 illustrates a bettor classification module, according to an embodiment.

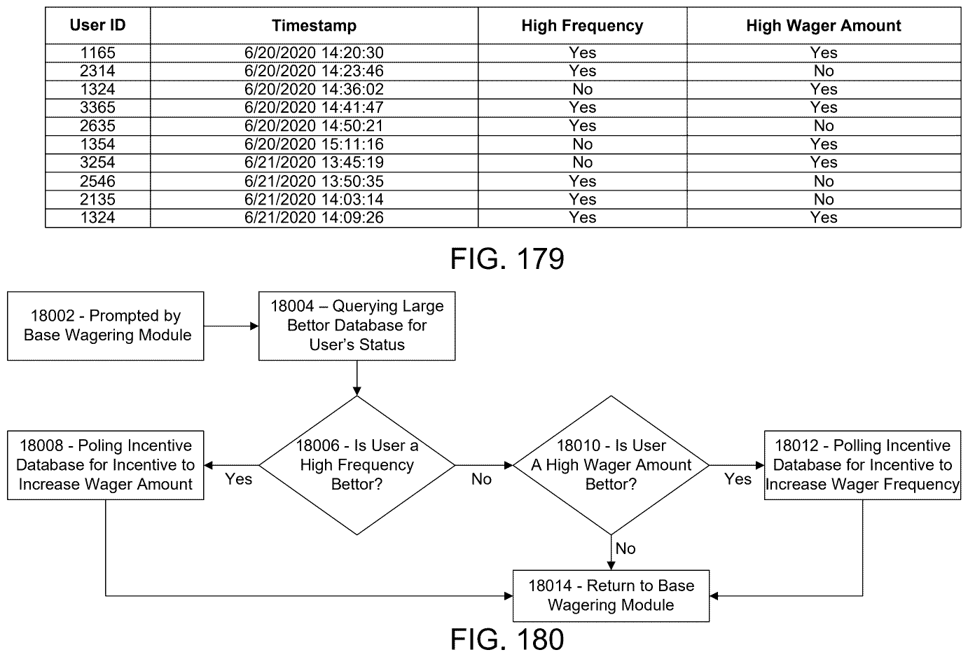

FIG. 179 illustrates a large bettor database, according to an embodiment.

FIG. 180 illustrates an incentive module, according to an embodiment.

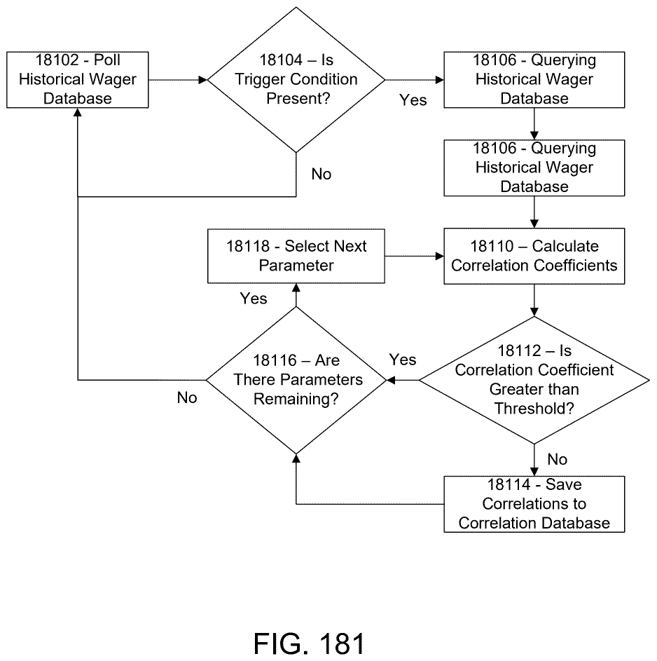

FIG. 181 illustrates an incentive assessment module, according to an embodiment.

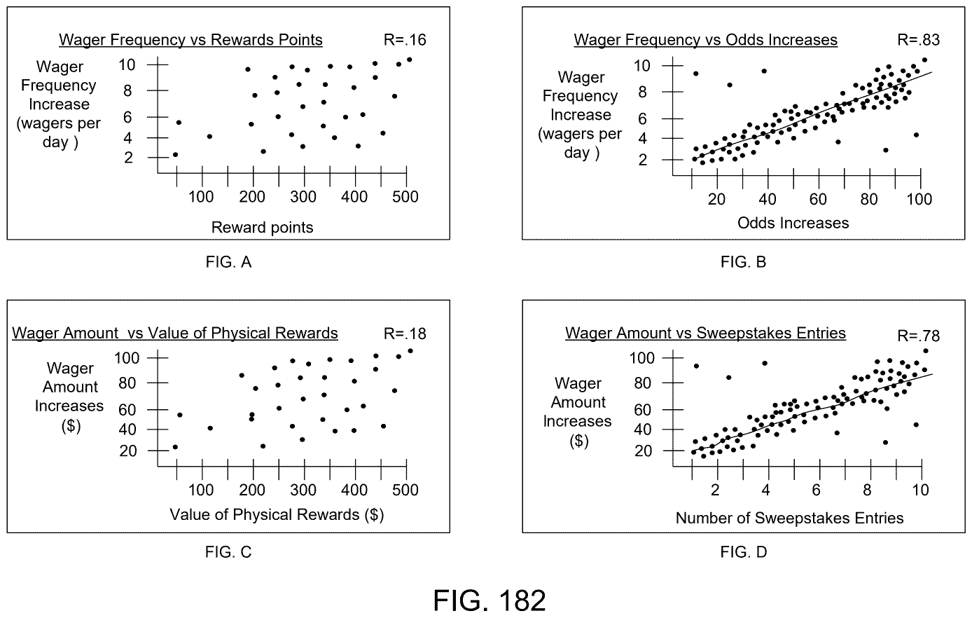

FIG. 182A illustrates an embodiment of an incentive database, according to an embodiment.

FIG. 182B illustrates an embodiment of an incentive database, according to an embodiment.

FIG. 182C illustrates an embodiment of an incentive database, according to an embodiment.

FIG. 182D illustrates an embodiment of an incentive database, according to an embodiment.

FIG. 175 is a system for a wager reward method. This system comprises of a live event 17502, for example a sporting event such as a football game, basketball game, baseball game, hockey game, tennis match, golf tournament, eSports, or digital game, etc. The live event will include some number of actions or plays, upon which a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game was the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 17502, such as the score of American football or the run line in baseball, or a series of action in the live event 17502. Sportsbooks have a number of bets they can handle, and a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a gambler to bet on both sides at different point spreads in order to middle and win both bets. Sportsbooks will often offer bets on portions of games, such as first half bets and half-time bets. Additionally, the sportsbook can offer futures bets on the live events 17502 in the future. Sportsbooks need to offer payment processing services in order to cash out customers. This can be done at kiosks at the live event 17502 or at another location.

Further, embodiments may include a plurality of sensors 17504 that may be used such as motion sensors, temperature sensors, humidity sensors, cameras such as an RGB-D Camera which is a digital camera capturing color (RGB) and depth information for every pixel in an image, microphones, a radiofrequency receiver, a thermal imager, a radar device, a lidar device, an ultrasound device, a speaker, wearable devices etc. Also, the plurality of sensors 17504 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball.

Further, embodiments may include a cloud 17506 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, such as over the Internet, and relies on sharing of resources to achieve coherence and economics of scale, like a public utility, while third-party clouds enable organizations to focus on their core businesses instead of expending resources on computer infrastructure and maintenance. The cloud 17506 may be communicatively coupled to a wagering network 17508 which may perform real time analysis on the type of play and the result of the play. The cloud 17506 may also be synchronized with game situational data, such as the time of the game, the score, location on the field, weather conditions, and the like which may affect the choice of play utilized. For example, in some exemplary embodiments, the cloud 17506 may not receive data gathered from the plurality of sensors 17504 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein.

Further, embodiments may include the wagering network 17508 which may perform real time analysis on the type of play and the result of a play or action. The wagering network 17508 (or cloud 17506) may also be synchronized with game situational data, such as the time of the game, the score, location on the field, weather conditions, and the like which may affect the choice of play utilized. For example, in some exemplary embodiments, the wagering network 17508 may not receive data gathered from the plurality of sensors 17504 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 17508 may offer a number of software as a service managed services such as, user interface service, risk management service, compliance, pricing and trading service, IT support of the technology platform, business applications, game configuration, state based integration, fantasy sports connection, integration to allow the joining of social media, and marketing support services that can deliver engaging promotions to the user.

Further, embodiments may utilize a user database 17510 which contains data relevant to all users of the system, which may include, a user ID, a device identifier, a paired device identifier, wagering history, and wallet information for each user.

Further, embodiments may include an odds calculation module 17512 which utilizes historical play data to calculate odds for in-play wagers.

Further, embodiments may include a historical play database 17514, that contains play data for the type of sport being played in the live event 17502. For example, in American Football, for optimal odds calculation, the historical play data should include meta data about the historical plays, such as time, location, weather, previous plays, opponent, physiological data, etc.

Further, embodiments may utilize an odds database 17516 that contains the odds calculated by the odds calculation module 17512, and the multipliers for distance and path deviation, and is used for reference by a base wagering module 17520 and to take bets from the user through a user interface and calculate the payouts to the user.

Further, embodiments may utilize a historical wager database 17518 that contains wagers from the live events 17502. Wagers may include a wager amount, odds, and an outcome such that a payout in the amount of the wager amount multiplied by the odds will be paid to a user if the outcome wagered on occurs, otherwise the wager amount being lost. The historical wager database 17518 may additionally contain contextual data about the state of the live event 17502 when the wager was placed.

Further, embodiments may include the base wagering module 17520 which allows a user to log into the wagering network 17508 and retrieve available wagers from the odds database 17516. The base wagering module 17520 prompting a bettor classification module 17522 which classifies the user as a high frequency bettor if their wager frequency exceeds a threshold or a high wager amount bettor if their average wager amount exceeds a threshold and saves the user's large bettor status to a large bettor database 17524. The base wagering module 17520 may further prompt an incentive module 17526 which uses the user's large bettor status to determine an incentive to offer to the user when displaying available wagers, such as improving the odds to encourage the user to increase their wager amount or their wager frequency. It then receives a wager from the user, polls for play completion and compares the results of the play to the wager to determine whether the user won or lost the wager and saves the wager data to the historical wager database 17518 and adjusts the user's account balance in the user database 17510. If the live event 17502 is complete, ending the program, otherwise repeating the base wagering module 17520.

Further, embodiments may include the bettor classification module 17522 which updates the large bettor database 17524 with whether a user is a high frequency bettor or a high wager amount bettor. The bettor classification module 17522 runs routinely, which may include after each play, after each number of plays, after a period of time, or be based upon some financial change (such as when the system's rate of profit is reducing) etc. This module may find large bettors by classifying all users by collecting data related to the number of wagers and the amount of each wager. The classification can be, but is not limited to, a number of bets, such as the top 10% of the bettors, bettors with more than 20 bets in a given period of time, bettors with an increasing trend in wagers placed over time, etc. The classification can be, but is not limited to, an amount of bets, such as the top 10% of users' wager amount for an individual bet, bettors with more than $2000 worth of bets in a given period of time, bettors with an increasing trend in the amount of wagers placed over time, etc. The bettor classification module 17522 may also use a hybrid classification such as a combination of the classification by number of bets and the classification by wager amount.

Further, embodiments may include the large bettor database 17524 which stores data calculated by the bettor classification module 17522. The large bettor database 17524 may include user IDs, whether the user is a high frequency bettor or a high wager amount bettor and may additionally include a time stamp indicating when the user was most recently classified as a large bettor.

Further, embodiments may include the incentive module 17526 which retrieves a user's large bettor status from the large bettor database 17524 and determines an incentive to offer to a user to increase their wager amount if a high frequency bettor or their wager frequency if a high wager amount bettor. Incentives are identified by an incentive assessment module 17528 and saved to an incentive database 17530 which is polled by the incentive module 17526 to identify an incentive to provide the user to achieve a desired target wager frequency or wager amount as defined by the administrator of the wagering network 17508.

Further, embodiments may include the incentive assessment module 17528 which continuously polls the historical wager database 17518 for a trigger condition such as the conclusion of a play or before or at the conclusion of the live event 17502 or at specific time intervals which may be defined by the administrator of the wagering network 17508. The incentive module 17528 further queries the historical wager database 17518 for historical wager data and performs correlations between data parameters to identify combinations of parameters which have a correlation coefficient exceeding a predetermined threshold. The incentive assessment module 17528 saves the correlations to an incentive database 17530.

Further, embodiments may include the incentive database 17530 which stores correlation data calculated by the incentive assessment module 17528.

Further, embodiments may include a mobile device 17532 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices provides for voice recognition and inputs, including, e.g., Microsoft KINECT, SIRI for IPHONE by Apple, Google Now or Google Voice Search. Additional user devices may have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 17532 could be an optional component and would be utilized in a situation in which a paired wearable device is utilizing the mobile device 17532 as additional memory or computing power or connection to the internet.

Further, embodiments may include a wagering app 17534, which is a program that enables the user to place bets on individual plays in the live event 102, and display the audio and video from the live event 17502, along with the available wagers on the mobile device 17532. The wagering app 17534 allows the user to interact with the wagering network 17508 in order to place bets and provide payment/receive funds based on wager outcomes.

FIG. 176 illustrates the historical wager database 17518. The historical wager database 17518 stores data about wagers placed by users during the live event 17502 including prior events. The data may include any of a user ID, wager amount, event ID and time stamps indicating when the wager was placed. The user ID identifying the user of the wagering network 17508 who placed the wager, a wager amount is a monetary value wagered by the user, the event ID identifying the live event 17502 during which the wager was placed. The data may additionally include initial odds, offered odds, and an outcome where the initial odds are the odds calculated by the odds calculation module 17512, the offered odds are the odds offered to a user. A wager is won if the outcome, the result of a play, wagered upon by the user occurs. The historical wager database 17518 may further include situational context about the live event 17502 when the wager was placed. In a baseball game, the situational context data may include the inning, teams playing, players batting, on deck pitching or playing in the field, score, balls, strikes, etc. The historical wager database 17518 is populated by the base wagering module 17520 and is used by the bettor classification module 17522 to classify users as high frequency bettors or high wager amount bettors and the incentive assessment module 17528 to identify correlations in parameters such that the increase of one parameter can increase the correlated parameter as set by the administrator of the wagering network 17508.

FIG. 177 illustrates the base wagering module 17520. The process begins with a user logging into, at step 17702, the wagering network 17508 via a user interface by entering a username and a password. In an embodiment, the username is an email address, and the password is a combination of alphanumeric characters. The module retrieves, at step 17704, the currently available wagers from the odds database 17516. The wagers may include an outcome and odds such that the outcome is the condition which must be met during the play to win the wager and the odds represent the multiple by which the wager amount placed by a user will be multiplied to determine the payout due to the user if the wager is won. The odds may alternatively be represented as a moneyline such that a positive number indicates the amount of money which will be won per $100 wagered and a negative number indicates the amount of money needed to wager to win $100. In a baseball game between the Boston Red Sox and the New York Yankees, an available wager is that the Red Sox pitcher, Eduardo Rodriguez, will strike out the next batter for the Yankees, Aaron Judge at odds of +500. The module prompts, at step 17706, the bettor classification module 17522. The bettor classification module 17522 queries the historical wager database 17518 for wager data for users of the wagering network 17508 and determines the wager frequency of each user. The module further compares the wager frequency for each user to a frequency threshold and saving the user to the large bettor database 124 as a high frequency bettor if the user's wager frequency is higher than the frequency threshold. Additionally, the modules determines the average wager amount of each user and compares the average wager amount to an amount threshold and saves the user to the large bettor database 17524 as a high wager amount bettor if the user's average wager amount is higher than the amount threshold, the module then returns to the base wagering module 17520. The module prompts, at step 17708, the incentive module 17526. The incentive module 17526 queries the large bettor database 17524 for the large bettor status of the user and identifying whether the user is a high frequency bettor. If the user is a high frequency bettor, the incentive module 17526 polls the incentive database 17530 for an incentive to offer the user to increase their next wager amount. If the user is not a high frequency bettor, then the incentive module 17526 identifies whether the user is a high wager amount bettor, and if so, polls the incentive database 17530 for an incentive to offer the user to increase their wager frequency, such as the number of wagers placed per day. The base wagering module 17520 displays, at step 17710, available wagers to the user via the wagering app 17532 on the mobile device 17532. The available wagers may include an outcome and odds. The odds displayed are adjusted by the incentive module 17526 if the user is a large bettor. In the example, the user Joc Smith is offered to wager that Red Sox pitcher Eduardo Rodriguez will strike out the next batter for the Yankees, Aaron Judge at odds of +520, increased by 20 from +500 because the user Joc Smith is a high wager amount bettor. The wagers may additionally include a default wager amount. The base wagering module 17520 receives, at step 17712, at least one wager from a user from the available wagers. The wager may include a wager amount, outcome, and odds. In the example, user Joe Smith bets $150 that Red Sox pitcher Eduardo Rodriguez will strike out Aaron Judge at odds of +520. The base wagering module 17520 polls, at step 17714, the plurality of sensors 17504 for play completion. Completion of the play indicates that the result of the play can be acquired and compared to the outcome wagered on by the user. In the example, the play is complete when the batter for the Yankees, Aaron Judge, returns to the dugout or is standing on a base. The module compares, at step 17716, the results of the play to the outcome wagered on by the user. The wager is won if the results of the play match the outcome wagered on by the user, while the wager is lost if the results of the play and the outcome wagered on by the user are different. In the example, the play resulted in the batter, Aaron Judge, hitting a fly ball to left field and the ball being caught by the Red Sox left fielder for an out. The user Joc Smith, having wagered $150 at +520 odds that Aaron Judge would strike out, lost the wager, as Aaron Judge did not strike out. The module saves, at step 17720, wager data to the historical wager database 17518. The wager data may include wager amount, odds, outcome, contextual information about the live event 17502 and metadata from the wager such as a timestamp indicating when the wager was placed. The wager data may further include the result of the wager, such as whether the wager was won or lost and the payout or loss resulting from the wager. The saved data allows the bettor classification module 17522 to determine whether a user is a high frequency bettor or a high wager amount bettor. The base module 17520 adjusts, at step 17820, the account balance of the user in the user database 17510 based on the results of the wager. If the wager is won, then the account balance is increased in an amount equal to the payout. The payout is determined based upon the odds accepted when the user placed the wager. In the example the unmodified odds are +500 and if the wager amount is $150, the payout would be $750. If the wager amount was not debited from the account balance prior to play completion, then the account balance is adjusted by the difference between the wager amount and payout. Similarly, if the wager was lost and the wager amount was not previously debited from the account balance, the account balance is reduced by the wager amount. The module polls, at step 17722, the plurality of sensors 17504 for whether the live event 17502 is complete. If the live event 17502 is not complete, the module returns to step 17704 and repeats the base wagering module 17520 program. The program ends at step 17724 if the live event 17502 is complete.

FIG. 178 illustrates the bettor classification module 17522. The process begins with the module receiving, at step 17802, a prompt from the base wagering module 17520 and initiating. The bettor classification module 17522 may run routinely, such as after each play, after each number of plays, after a period of time, or based upon some financial change (the system rate of profit is reducing) etc. The module queries, at step 17804, the historical wager database 17518 for historical wager data. The historical wager data may include the user's past wagers and may additionally include historical wager data for other users. The historical wager data may include user IDs, wager amounts, time stamps indicating when the wagers were placed, and additionally may include an event ID. The historical wager data may be used to determine wager frequency and an average wager amount for each user for which data is retrieved. The data may further be filtered based on the type of the live event 17502, such as baseball game or American football game, and may additionally be filtered for a specific time period, such as the previous month. The module determines, at step 17806, the wager frequency for each users' historical wagers. The wager frequency may be represented as wagers placed per period of time, such as week, day, hour etc. or per event or user session on a wagering app 17534. The wager frequency is determined by counting the total number of wagers placed by a user and dividing it by the number of time units during which the wagers were placed as determined by the wager record time stamps. Alternatively, the event ID can be used to identify the wagers placed in a single event. In the example, user Joe Smith placed 98 wagers during the past two weeks and therefore averaged 14 wagers per day. The module compares, at step 408, the user's wager frequency to a frequency threshold. The frequency threshold may be set by an administrator of the wagering network 17508 or by an algorithm. In this example, the frequency threshold is set by the administrator of the wagering network 17508 to 10 wagers per day and the user Joe Smith, having averaged 14 wagers per day during the past two weeks, has a wager frequency greater than the frequency threshold. The frequency threshold may alternatively be defined by a relative rank among other users, such as the top 10% of all users' wager frequencies, or an increasing trend in the user's wager frequency, such as increasing by more than 10 wagers or 10% of wagers placed in the previous week. The module identifies, at step 17810, whether the user is a high frequency bettor by whether the user's wager frequency is greater than the frequency threshold. As the user Joe Smith's wager frequency is 14 wagers per day which is greater than the frequency threshold of 10 wagers per day, the user Joe Smith is a high frequency bettor. The module saves, at step 17812, the user to the large bettor database 17524 as a high frequency bettor if the user is determined to be a high frequency bettor. The module determines, at step 17814, each users' average wager amount. The average wager amount is determined by summing the wager amounts for a user's wagers and dividing the summed wager amounts by the total number of wagers placed. In the example, user Joe Smith placed 98 wagers during the past two weeks and the sum of all 98 wagers placed equals $12,250. User Joe Smith therefore has an average wager amount of $125 during the past two weeks. The modules compares, at step 17816, the user's average wager amount to an amount threshold. The amount threshold may be set by an administrator of the wagering network 17508 or by an algorithm. In this example, the frequency threshold is set by the administrator of the wagering network 108 at $100 per wager and the user Joe Smith, having an average wager amount of $125 has a wager amount greater than the amount threshold. The amount threshold may alternatively be defined by a relative rank among other users, such as the top 10% of all users' average wager amounts, or an increasing trend in the user's wager amount, such as increasing by more than $20 or 20% of wagers placed in the previous week. The module identifies, at step 17818, whether the user is a high wager amount bettor by whether the user's average wager amount is greater than the amount threshold. As the user Joe Smith's average wager amount is $125 and the amount threshold is $100, the user Joe Smith is a high wager amount bettor. The module saves, at step 17820, the user to the large bettor database 17524 as a high wager amount bettor if the user is determined to be a high wager amount bettor. The module returns, at step 17822, to the base wagering module 17520.

FIG. 179 illustrates the large bettor database 17524. The large bettor database 17524 stores the large bettor status of users which may include a user ID, high frequency bettor status, high wager amount status, and a timestamp indicating the date and time when the bettor classification module 17522 determined that the user was a large bettor. The high frequency bettor status indicates that the user places wagers at a frequency above a threshold or at a rate higher than most other users. The high wager amount bettor status indicates that the user places wagers which are, on average, larger than a threshold or their average wager amount is greater than most other users. The large bettor database 17524 is used by the incentive module 17526 to select the incentive to be offered to a user.

FIG. 180 illustrates the incentive module 17526. The process begins with the module receiving, at step 18002, a prompt from the base wagering module 17520 which initiates the incentive module 17526. The incentive module 17526 determines what, if any, incentive to offer to the user to encourage the user to increase their wager frequency or wager amount. The module queries, at step 18004, the large bettor database 17524 for the user's large bettor status. The large better status may be a high frequency bettor or a high wager amount bettor. The module identifies, at step 18006, whether the user is a high frequency bettor based on the user's large bettor status. A high frequency bettor is a user who places more wagers than most other users. The module polls, at step 18008, the incentive database 17530 for an incentive to offer the user to increase their wager amount to meet or exceed a target increase in wager amount set by the administrator of the wagering network 17508 or an algorithm. The incentive is determined by identifying the parameter with the strongest correlation with an increase in wager amount as indicated by the highest correlation coefficient. In the example, an increase in sweepstakes entries has the strongest correlation with an increase in wager amount with a correlation coefficient of 0.78. A regression is then calculated to predict the additional number of sweepstakes entries to achieve the target increase in wager frequency, which in this example was predefined by the administrator of the wagering network 17508 at an increase of $25. The result is three sweepstakes entries. The module identifies, at step 18010, whether the user is a high wager amount bettor based on the user's large bettor status. A high wager amount bettor is a user who places larger wagers than most other users. The module polls, at step 18012, the incentive database 17530 for an incentive to offer the user to increase their wager frequency to meet or exceed a target increase in wager frequency set by the administrator of the wagering network 17508 or an algorithm. The incentive is determined by identifying the parameter with the strongest correlation with an increase in wager frequency as indicated by the highest correlation coefficient. In the example, an increase in odds is correlated with an increase in wager frequency as represented by a correlation coefficient of 0.83. A regression is then calculated to predict the amount by which the odds must increase to achieve the target increase in wager frequency, which in this example was predefined by the administrator of the wagering network 17508 at an increase of two wagers per day. The result is an odds increase of +40. The module returns to the base wagering module 17520 with the incentive to be offered to the user. If the user is not a high frequency bettor nor a high wager amount bettor, then the module returns to the base wagering module 17520 without an incentive and offers the user available wagers without providing an incentive.

FIG. 181 illustrates the incentive assessment module 17528. The process begins with the module polling, at step 18102, the historical wager database 17518 for a trigger condition. A trigger condition may be any of the conclusion of a play, a period of time which may be set by the administrator of the wagering network 17508, at the beginning or end of the live event 17502, or upon some financial change, such as the system rate of profit reducing, etc. In the example, the historical wager database 17518 is triggered at the conclusion of each play when new wager data is saved to the historical wager database 17518. The module checks, at step 18104, for the presence of a trigger condition in the data stored in the historical wager database 17518. The module determines the presence of a trigger condition, which may include a calculation step such as calculating the system rate of profit for a decreasing trend. In the example, the trigger condition is present when new wager data is saved to the historical wager database 17518 when a play ends and the result of a wager is determined. The module queries, at step 18106, the historical wager database 17518 for historical wager data. The historical wager data may include past wagers for all users. The historical wager data may include user IDs, wager amounts, time stamps indicating when the wagers were placed, event IDs, incentives offered to users, context of the live event, etc. The historical wager data will be used to identify correlations between parameters to identify the parameters which result in a desired change in user behavior, such as increasing the frequency of wagers or increasing the amount of wagers. The data may be filtered based on type of the live event 17502, such as baseball game or American football game, and may additionally be filtered for a specific time period, such as the previous month. The module selects, at step 18108, a first parameter from the available parameters from the historical wager data. The parameter may include any of wager amount, odds, an outcome, contextual information from the live event 17502, etc. The parameter may additionally be a value determined per user or per period of time such as wager frequency. In this example, the selected parameter is the wager frequency expressed as wagers placed per day. The module calculates, at step 18110, a correlation coefficient for each pairing of the selected parameter and each unselected parameter. The correlation coefficient is a measure of the correlation between the selected parameter and a second parameter which can indicate the degree of influence of one parameter on the other. The closer a correlation coefficient is to 1, the stronger the implied positive influence such that increasing one parameter will similarly increase the second. In this example, the correlation coefficient of an increase in wager frequency in response to an increase in odds is 0.83. Additionally, the correlation coefficient of an increase in wager frequency in response to an increase in reward points awarded for a wager is 0.16. The correlation method used in this example is the Pearson r correlation, although any correlation method can be used. A negative correlation coefficient indicates an inverse relationship such that when one parameter is increased the other decreases. The module compares, at step 18112, the correlation coefficients to a threshold value to determine whether the selected parameter is correlated to each of other unselected parameters. As the correlation coefficient approaches 1, the parameters are more highly correlated while parameters are less correlated as the correlation coefficient approaches 0. The threshold value, which may be defined by the administrator of the wagering network 108 or determined by an algorithm, represents the boundary between correlated parameters and non-correlated parameters. Therefore, if the correlation coefficient exceeds the threshold value, the parameters are determined to be correlated such that the change in one parameter will result in a proportional change in other correlated parameters. In the example, a threshold value is predefined as 0.75 by an administrator of the wagering network 17508. The Pearson correlation formula is used to calculate a correlation coefficient for the increase in wager frequency in response to an increase in odds payout which results in a correlation coefficient of 0.83. The correlation coefficient is greater than the threshold value, therefore an increase in wager frequency is correlated to an increase in odds. The correlation coefficient on an increase in wager frequency in response to an increase in reward points awarded for a wager is 0.16 which is less than the 0.75 threshold value, therefore the increase in wager frequency is not correlated with an increase in reward points. Alternate methods of comparing parameters may be used including convolution or regression. The module saves, at step 18114, correlations to the incentive database 17530. The correlations including a pair of parameters, the correlation coefficient representing the strength of the correlation, and a time stamp indicating the time at which the correlation was saved to the incentive database 17530. The correlations may additionally include a regression which can be used to predict the increase in one parameter needed to increase the other parameter. In the example, the correlation of wager frequency and odds with a correlation coefficient of 0.83 is saved to the incentive database 17530 on Jun. 20, 2020 at 14:22:28. The module checks, at step 18116, if there are more parameters which have not been evaluated for correlation if none of the correlation coefficients for the previously selected parameter are greater than the threshold value. Each parameter should be evaluated for correlation with each other parameter, and if this condition is not met, then another parameter which has not been evaluated should be selected and the previous two steps repeated with the new selected parameter. In the example, having completed correlations for wager frequency, the module identifies that at least the wager amount parameter has not been evaluated for correlations. The module selects, at step 18118, the next parameter which has not been evaluated for correlation. The next parameter is taken from the available parameters from the historical wager data. The module further returns to step 18110 to calculate correlation coefficients for each pairing of the now selected parameter and all unselected parameters. In the example, the module selects the wager amount parameter, as it has not been evaluated for correlation, and returns to step 18110.

FIG. 182 illustrates the incentive database 17530. The incentive database 17530 stores correlations identified by the incentive assessment module 17528. A correlation is a combination of parameters and a correlation coefficient such that the correlation coefficient represents the degree to which a first parameter has an impact on a second parameter. The incentive database 17530 is used by the incentive module 17526 to determine incentives to offer to a user to increase the user's wager frequency or wager amounts. FIG. 182A shows an example of non-correlated parameters comparing an increase in wager frequency resulting from an increase in reward points. The correlation coefficient is 0.16. When compared to a threshold value of 0.75, defined by the administrator of the wagering network 17508, the correlation coefficient is less than the threshold value and therefore it is determined that an increase in wager frequency is not correlated with an increase in reward points. FIG. 182B shows an example of correlated parameters comparing an increase in wager frequency resulting from an increase in odds. The correlation coefficient is 0.83. When compared to the threshold value of 0.75, the correlation coefficient is greater than the threshold value and therefore it is determined that an increase in wager frequency is correlated with an increase in odds. FIG. 182C shows an example of non-correlated parameters comparing an increase in wager amount resulting from an increase in the value of physical rewards. The correlation coefficient is 0.18. When compared to the threshold value of 0.75, the correlation coefficient is less than the threshold value and therefore it is determined that an increase in wager amount is not correlated with an increase in the value of physical rewards. FIG. 182D shows an example of correlated parameters comparing an increase in wager amount resulting from an increase in the number of sweepstakes entries offered to a user. The correlation coefficient is 0.78. When compared to the threshold value of 0.75, the correlation coefficient is greater than the threshold value and therefore it is determined that an increase in wager amount is correlated with an increase in the number of sweepstakes entries offered to a user.

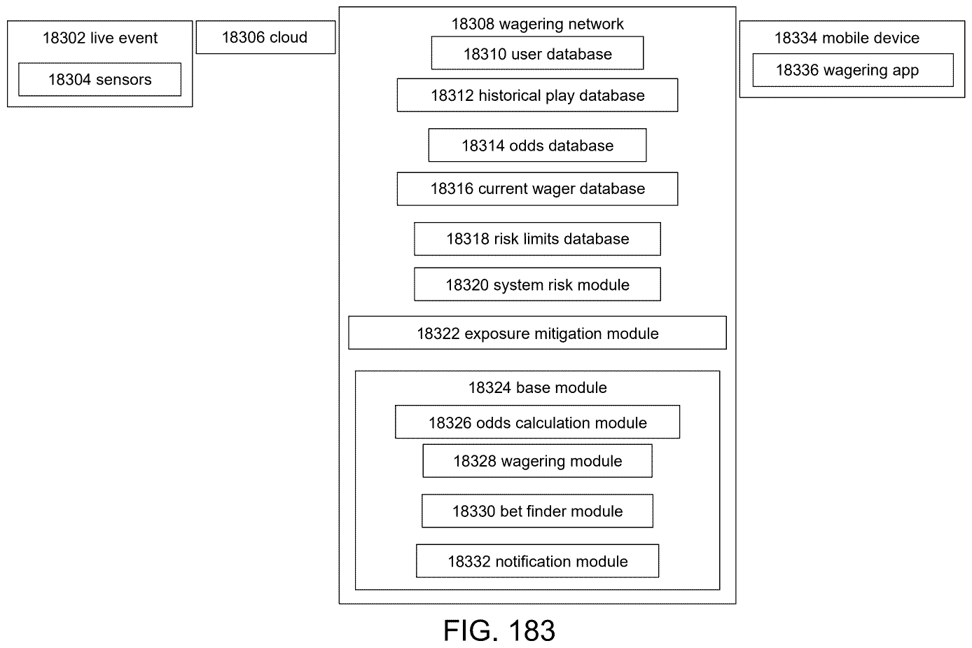

FIG. 183 illustrates a system for a method of displaying a notification from a betting application using AI that can impact normal betting, according to an embodiment.

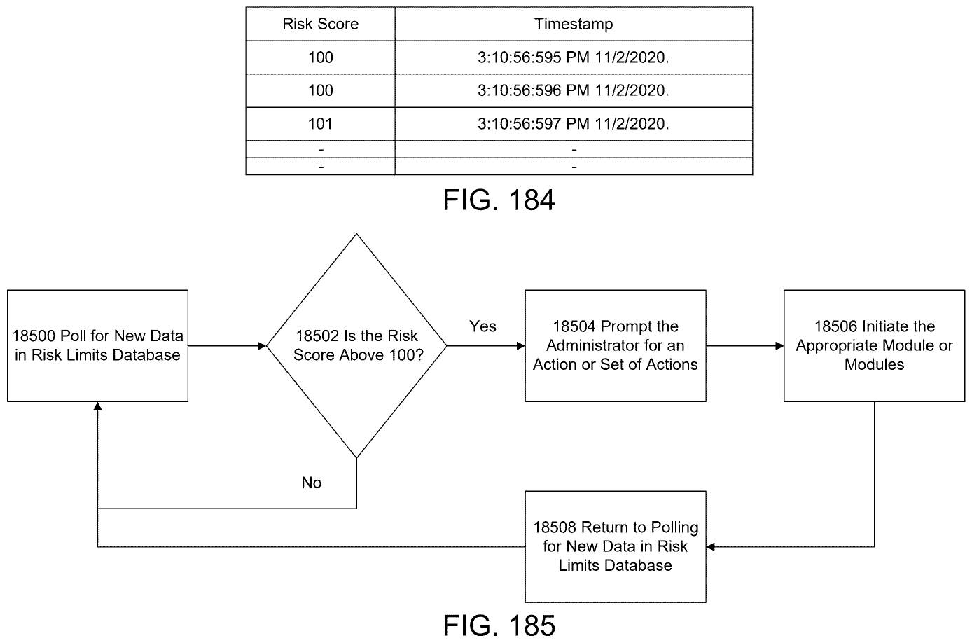

FIG. 184 illustrates a risk limits database, according to an embodiment.

FIG. 185 illustrates a system risk module, according to an embodiment.

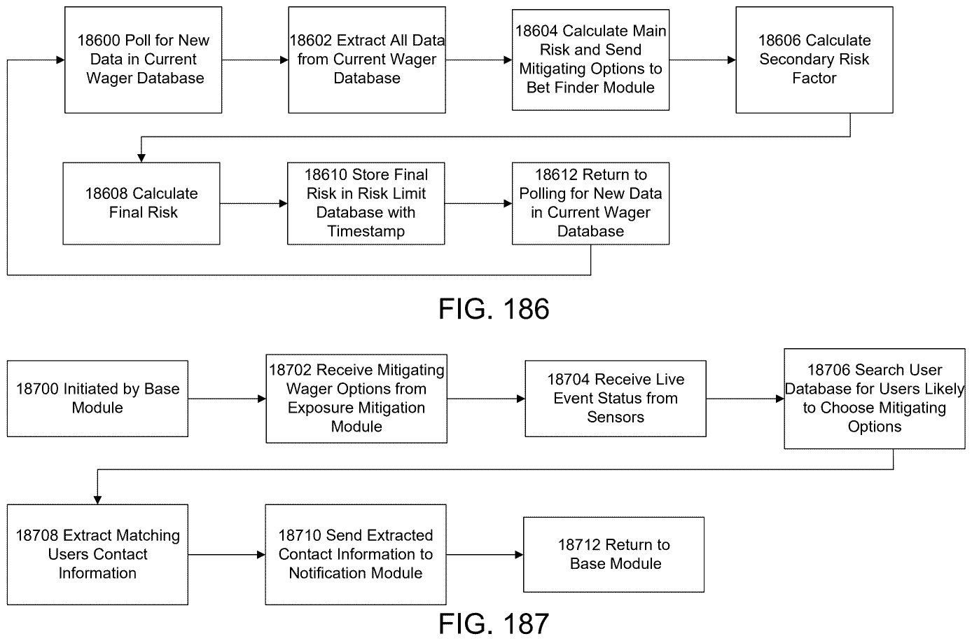

FIG. 186 illustrates an exposure mitigation module, according to an embodiment.

FIG. 187 illustrates a bet finder module, according to an embodiment.

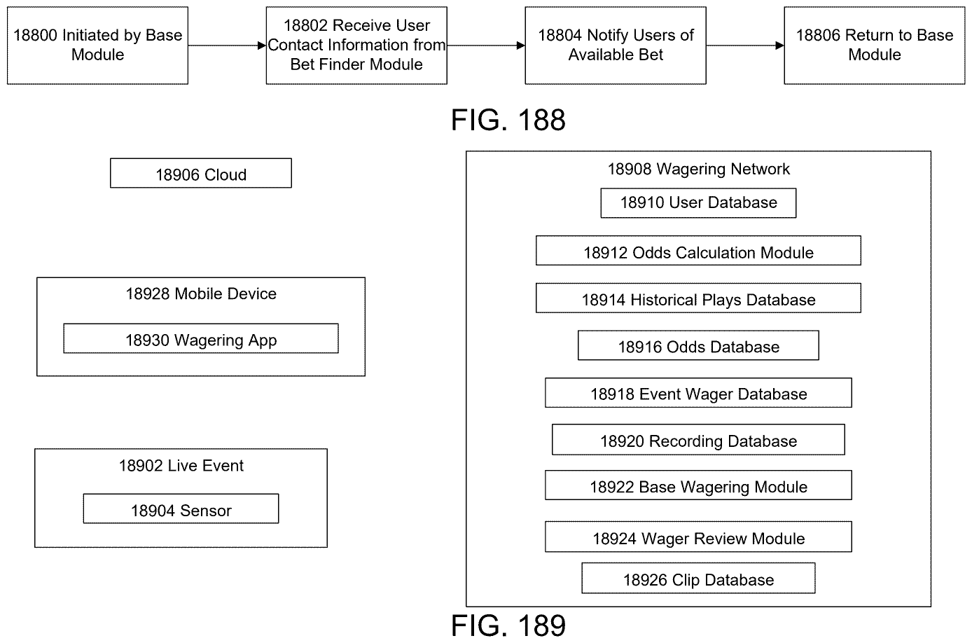

FIG. 188 illustrates a notification module, according to an embodiment.

FIG. 183 displays a system for a method of displaying a notification from a betting application using AI that can impact normal betting. This system is comprised of a live event 18302, for example a sporting event such as a football game, basketball game, baseball game, hockey game, tennis match, golf tournament, eSports or digital game, etc. The live event 18302 will include some number of actions or plays, upon which a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game was the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 18302, such as the score of American football or the run line in baseball, or a series of action in the live event 18302. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live events 18302 in the future. Sportsbooks need to offer payment processing services in order to cash out customers. This can be done at kiosks at the live event 18302 or at another location.

Further, embodiments may include a plurality of sensors 18304 that may be used such as motion sensors, temperature sensors, humidity sensors, cameras such as an RGB-D Camera which is a digital camera capturing color (RGB) and depth information for every pixel in an image, microphones, a radiofrequency receiver, a thermal imager, a radar device, a lidar device, an ultrasound device, a speaker, wearable devices etc. Also, the plurality of sensors 18304 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball.

Further, embodiments may include a cloud 18306 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, which may occur over Internet and relies on sharing of resources to achieve coherence and economies of scale, like a public utility, while third-party clouds enable organizations to focus on their core businesses instead of expending resources on computer infrastructure and maintenance. The cloud 18306 may be communicatively coupled to a wagering network 18308 which may perform real time analysis on the type of play and the result of the play. The cloud 18306 may also be synchronized with game situational data, such as the time of the game, the score, location on the field, weather conditions, and the like which may affect the choice of play utilized. For example, in some exemplary embodiments, the cloud 18306 may not receive data gathered from the plurality of sensors 18304 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein.

Further, embodiments may include the wagering network 18308 which may perform real time analysis on the type of play and the result of a play or action. The wagering network 18308 (or cloud 18306) may also be synchronized with game situational data, such as the time of the game, the score, location on the field, weather conditions, and the like which may affect the choice of play utilized. For example, in some exemplary embodiments, a wagering network 18308 may not receive data gathered from the plurality of sensors 18304 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 18308 may offer a number of software as a service managed services such as, but not limited to, user interface service, risk management service, compliance, pricing and trading service, IT support of the technology platform, business applications, game configuration, state based integration, fantasy sports connection, integration to allow the joining of social media, and marketing support services that can deliver engaging promotions to the user.

Further, embodiments may utilize a user database 18310 which contains data relevant to all users of the system, which may include, a user ID, a device identifier, a paired device identifier, wagering history, and wallet information for each user.

Further, embodiments may include a historical play database 18312 which contains play data for the type of sport being played in the live event 18302. For example, in American Football, for optimal odds calculation, the historical play data may include meta data about the historical plays, such as time, location, weather, previous plays, opponent, physiological data, etc.

Further, embodiments may utilize an odds database 18314 that contains the odds calculated by an odds calculation module 18326, and the multipliers for distance and path deviation, and is used for reference by a wagering module 18328 and to take bets from the user through a user interface and calculate the payouts to the user.

Further, embodiments may utilize a current wager database 18316 that contains a running tally of all open wagers so the system can calculate its current exposure level on each potential outcome of the coming play.

Further, embodiments may utilize a risk limits database 18318 that stores risks on wagers calculated by an exposure mitigation module 18322.

Further, embodiments may utilize a system risk module 18320 that alerts an administrator when the risk exposure of a play is too high. This gives the administrator a real time response to send an alert which might stop further bets in order to limit exposure before all bets are in.

Further, embodiments may utilize the exposure mitigation module 18322 that polls the current wager database 18316 for new data events (e.g. a new wager) and then calculates risk exposure on that outcome. The main focus of this module is imbalance of wagers on a play, in other embodiments the exposure mitigation module 18322 may account for other types of risk such as player injury, drastic weather change, or equipment failure.

Further, embodiments may utilize a base module 18324 that initiates the odds calculation module 18326, the wagering module 18328, a bet finder module 18330, and a notification module 18332.

Further, embodiments may include the odds calculation module 18326 which utilizes historical play data to calculate odds for in-play wagers.

Further, embodiments may include the wagering module 18328 which displays bet options to users and allows them to make a wager selection and wager an amount of money or credit.

Further, embodiments may include the bet finder module 18330 which first receives the level of risk calculated by the exposure mitigation module 18322 and based on the level of risk finds users who based on historical data tend to make bets that would offset the risk.

Further, embodiments may include the notification module 18332 which notifies users found by the bet finder module 18330 that a wager is available and encourages them to place a wager.

Further, embodiments may include a mobile device 18334 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allow for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 18334 could be an optional component and would be utilized in a situation in which a paired wearable device is utilizing the mobile device 18334 as additional memory or computing power or connection to the internet.

Further, embodiments may include a wagering app 18336, which is a program that enables the user to place bets on individual plays in the live event 18302, and display the audio and video from the live event 18302, along with the available wagers on the mobile device 18334. The wagering app 18336 allows the user to interact with the wagering network 18308 in order to place bets and provide payment/receive funds based on wager outcomes.

FIG. 184 displays the risk limits database 18318. The risk limits database 18318 contains risks on wagers calculated by the exposure mitigation module 18322. The risk is stored as a whole number or risk score, for example 100, and each stored risk has a time stamp of when it was calculated, for example, 3:10:56:595 PM Nov. 2, 2020. In some embodiments the accuracy of the timestamp may be dependent on the speed at which the exposure mitigation module 18322 updates. In some embodiments the risk limits database 18318 may contain additional identifiers to differentiate between different plays, games, wager options, etc.

FIG. 185 displays the system risk module 18320. The process begins with the system risk module 18320 polling, at step 18500, for new data in the risk limits database 18318. The system risk module 18320 determines, at step 18502, if the risk score of the new data is above 100. In other embodiments the threshold may be different than 100 and may be set by the administrator, a third party, or another module and may be static or dynamic. The system risk module 18320 prompts, at step 18504, the administrator for an action or set of actions to take; for example, the administrator may choose to close the betting window, change the odds, incentivize users to bet on options that would reduce the risk score, or any combination of those actions. In an embodiment a GUI may facilitate this selection of actions. The system risk module 18320 initiates, at step 18506, the module or modules corresponding to the action or actions selected by the administrator. For example, if the administrator selected to adjust the odds the system risk module 18320 may initiate an “odds adjustment module”. In some cases, the system risk module 18320 may not initiate modules directly but may indicate to another module, for example the base module 18324, which modules should be initiated. The system risk module 18320 returns, at step 18508, to polling for new data from the risk limits database 18318. In some embodiments the system risk module 18320 may wait for some amount of time before returning to polling for new data from the risk limits database 18318 in order to give the actions taken by the administrator time to take effect before checking if there is still a risk score above threshold.

FIG. 186 displays the exposure mitigation module 18322. The process begins with the exposure mitigation module 18322 polling, at step 18600, for new data in the current wager database 18316. The exposure mitigation module 18322 extracts, at step 18602, all data from the current wager database 18316. The exposure mitigation module 18322 calculates, at step 18604, a main risk based on the imbalance between selected wager options. Normally odds are calculated in such a way that despite the outcome of the play there is always enough money lost by users to pay off the money won by users. However, in cases where an unexpected number of users select one wager option, the offeror of the wager risks taking a loss. For example, in a simple play where there is only one possible result, two betting options “run” or “pass”, and the odds for each option are 2 to 1, then there is no risk if exactly half of all money is bet on each option, since the losses from the losing half will pay for the winnings of the winning half. However, if one additional dollar is wagered on “run” than “pass” then the bet offeror stands to lose money if the result of the play is a pass. To calculate risk for this example the exposure mitigation module 18322 could determine the amount of gain if a run occurs minus the amount of loss if a run occurs, and similarly for if a pass occurred. In this example only a run would result in a loss to the offeror of the bet, so the amount of loss would be multiplied by the likelihood of the outcome occurring to determine the risk, in this example the risk would be $1 multiplied by 50% (note that the internal odds of an outcome and the odds given to bettors may differ because the offeror of the bet usually earns money by slightly reducing the odds), and the risk would be $0.50. This 0.50 is the risk score for the main risk for the wager. In more complex wagers where there may be more than one result that causes a risk of loss, the risk will be the highest risk score among those results, in other embodiments the risk scores may be combined, for example, by taking an average. In some embodiments risk score could be created by a previously defined rule or could be developed by looking at past historical rates and amounts of the particular bets or groups of bets or all bets, using AI, to enhance the exposure risk. The wager options that do not contribute to the main risk are mitigating options, meaning users betting on these options would reduce the main risk. The exposure mitigation module 18322 sends these options to the bet finder module 18330. The exposure mitigation module 18322 calculates, at step 18606, a secondary risk factor based on known risks which would not have been accounted for in the original odds calculation. The exposure mitigation module 18322 determines from any known data about the play, if there is for example, (1) a past or current injury to a player key to the event in play, (2) drastic weather changes in a sporting event, or (3) star player equipment failure, this module searches through the wager history database, using AI, for any of these secondary risks. For instance, a key player's results were considerably reduced for 1-2 days after an injury and this was highly correlated. If this was found, a weighting factor is returned to be used to modify the main risk. The secondary risk factor is calculated from the historical play data based on the amount that the secondary risk contributed to an outcome that would result in a loss based on the main risk. For example, a wrist injury to the quarterback of a football game may often result in an increase in runs over passes. If the offeror of the bet stands to lose money on a run, then the risk factor would reflect the increased amount of plays that will result in runs. If runs are 20% more common when the quarterback of a football game has an injured wrist, then the secondary risk factor would be 1.2. In some embodiments, the secondary risk factor may be retrieved from a database of known risks, for example, if a player is injured, the exposure mitigation module 18322 may look up “player injury” in a database and may find an associated risk factor of 1.2. The exposure mitigation module 18322 calculates, at step 18608, the final risk score by multiplying the main risk by the secondary risk factor. In some embodiments there may be more than one secondary risk factor in which case the final risk may be calculated by multiplying the main risk by all secondary risk factors or by the largest secondary risk factor. The exposure mitigation module 18322 stores, at step 18610, the final risk score in the risk limits database 18318 with a timestamp. The exposure mitigation module 18322 returns, at step 18612, to polling for new data in the current wager database 18316.

FIG. 187 displays the bet finder module 18330. The process begins with the bet finder module 18330 being, at step 18700, initiated by the base module 18324. The bet finder module 18330 receives, at step 18702, mitigating wager options sent by the exposure mitigation module 18322. The bet finder module 18330 receives, at step 18704, data on the status of the live event 18302 from the plurality of sensors 18304. For example, the bet finder module 18330 may receive data that identifies the live event 18302 as a football game between the Los Angeles Chargers and the Denver Broncos, wherein the Broncos are on offense, it is 3rd and 10 and 3 minutes into the 4th quarter, and the weather is fair. The bet finder module 18330 searches, at step 18706, for users likely to choose the mitigating wager options. The bet finder module 18330 looks for users with a history of betting for the mitigating wager options more often than average and may use filters to narrow down the search closer to the current state of the live game. For example, based on the data from the plurality of sensors 18304 the live event 18302 is a football game between the Los Angeles Chargers and the Denver Broncos, wherein the Broncos are on offense, it is 3rd and 10 and 3 minutes into the 4th quarter, and the weather is fair. Two wager options are available to users, “run” or “pass”, and an unexpected number of users have selected “run”. The exposure mitigation module 18322 has determined that there is a risk of loss because of the imbalance between the two wager options and has sent the wager option “pass” to the bet finder module 18330 as a mitigating wager option. The bet finder module 18330 searches the user database 18310 for users who often, or at least more often than average, choose the wager option pass when the Broncos are playing against the Chargers, the Broncos are on offense, it is 3rd and 10 and 3 minutes into the 4th quarter, and the weather is fair. In some embodiments not every filter must match the exact state of the live event 18302, for example, wagers made by users when the Broncos were not playing the Chargers or when it is 3rd and 9 instead of 3rd and 10 may be included. In some embodiments the amount and strictness of the filters may be based on the amount of users needed to mitigate risk, for example, if an estimated 1000 users are needed to bet on the mitigating option, the bet finder module 18330 may find 1000 users, starting with those with bets made that most closely match the state of the live event 18302 then reducing the threshold requirements to be considered similar until 1000 users are found. In some embodiments an artificial intelligence algorithm will determine which parameters are correlated with the chosen bet options and filter the search based on only the parameters that significantly affect wager selection. The bet finder module 18330 extracts, at step 18708, the contact information of the matching users. Contact information refers to any method by which the user can be notified of an available wager for example, an email, phone number, or an identifier such as a username by which the user can be sent a notification via the wagering app 18336. The bet finder module 18330 sends, at step 18710, the extracted contact information for each user to the notification module 18332. The bet finder module 18330 returns, at step 18712, to the base module 18324.

FIG. 188 illustrates the notification module 18332. The process begins with the notification module 18332 being, at step 18800, initiated by the base module 18324. The notification module 18332 receives, at step 18802, user contact information from the bet finder module 18330. The notification nodule 18332 notifies, at step 18804, each user of the available wager. For example, user John Smith is identified by the bet finder module 18330 as a user who often bets on “pass” which is a mitigating wager option. The notification module 18332 sends John Smith a message based on his contact information, since his contact information is a phone number the notification module 18332 sends the message via SMS text. The message informs John Smith that there is a wager available with text that reads “A wager is available that we think you would like!”. In some embodiments the notification module 18332 may contain a link which opens up the wagering app 18336 if not already open, or may open to a wager associated with or referred to in the notification. In some embodiments the notification may contain incentives such as discounts, increased odds, free credit, etc. especially if the user chooses the mitigating wager option. The notification module 18332 returns, at step 18806, to the base module 18324.

FIG. 189 illustrates a system for wagering system that provides for replaying certain bets, according to an embodiment.

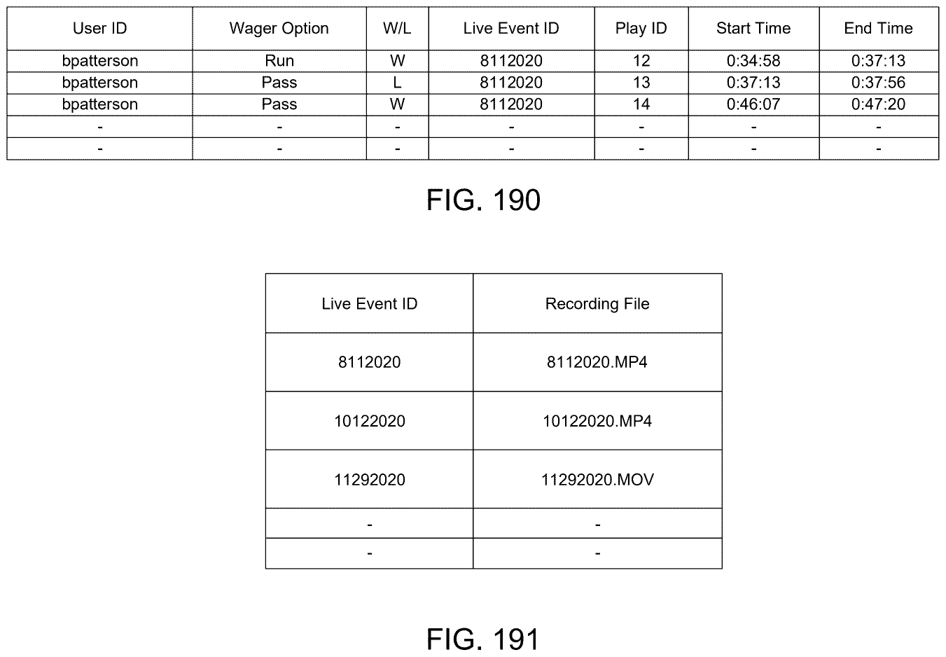

FIG. 190 illustrates an event wager database, according to an embodiment.

FIG. 191 illustrates a recording database, according to an embodiment.

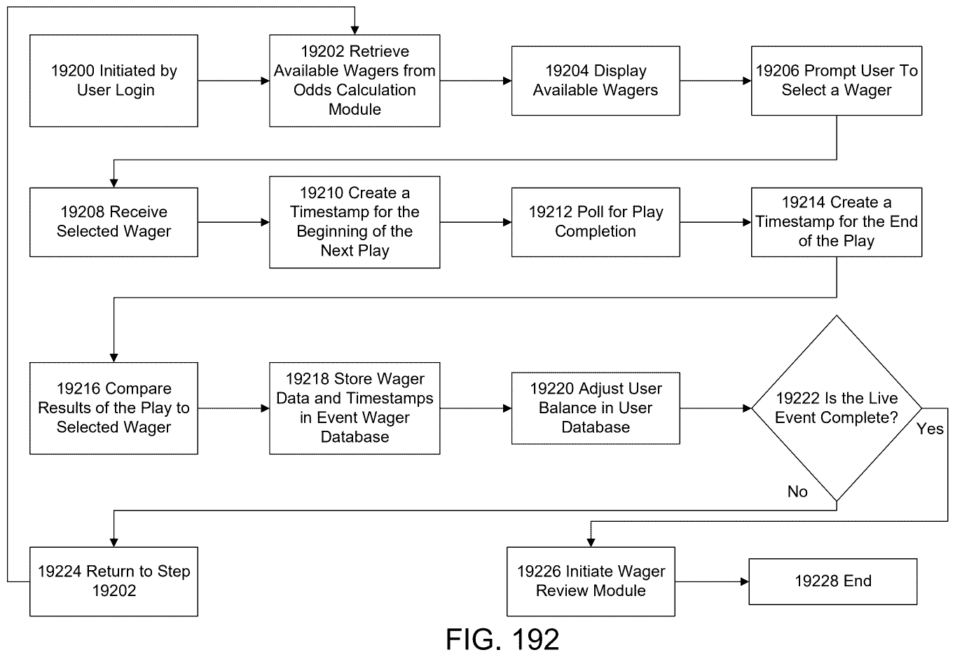

FIG. 192 illustrates a base wagering module, according to an embodiment.

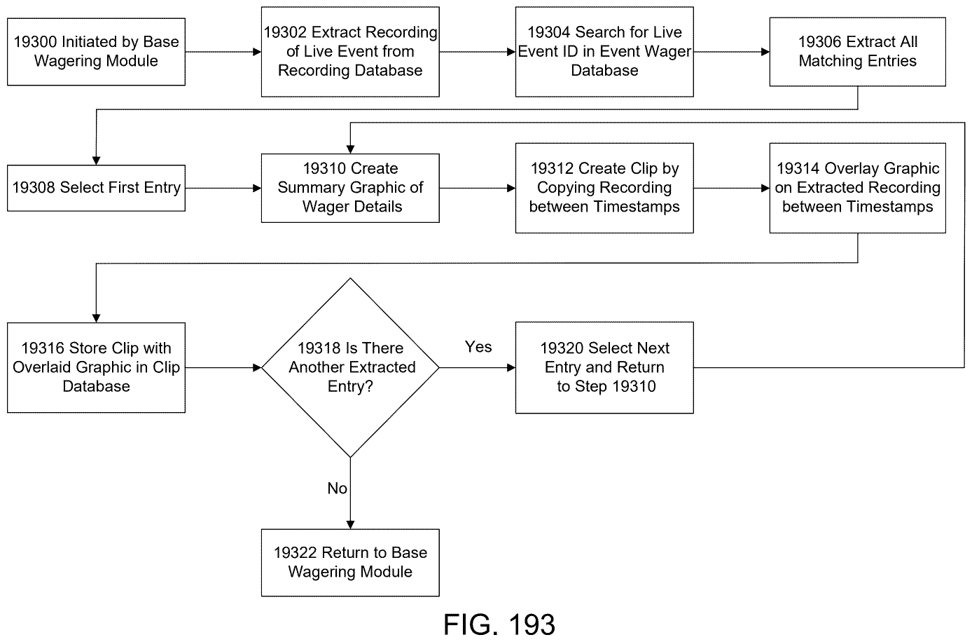

FIG. 193 illustrates a wager review module, according to an embodiment.

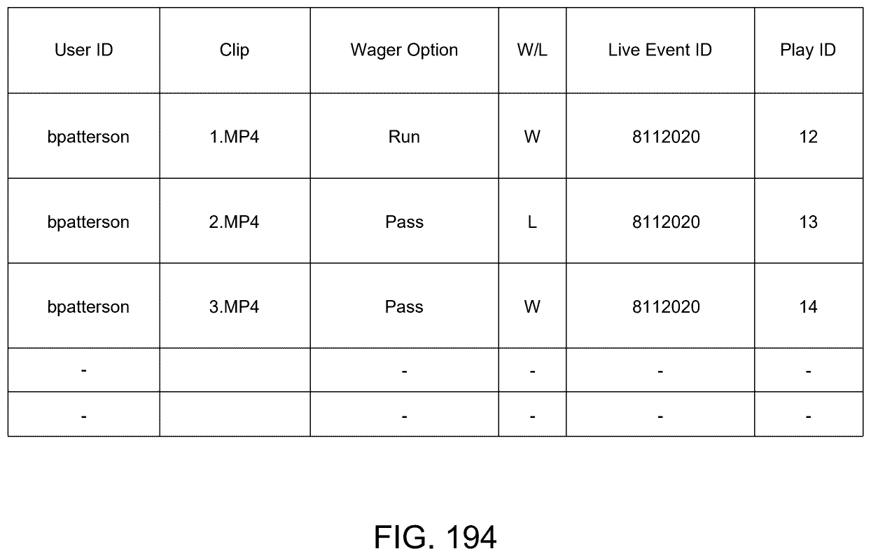

FIG. 194 illustrates a clip database, according to an embodiment.

FIG. 189 displays a system for wagering system that provides for replaying certain bets. This system may include a live event 18902, for example a sporting event such as a football game, basketball game, baseball game, hockey game, tennis match, golf tournament, eSports or digital game, etc. The live event 18902 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 18902, such as the score of American football or the run line in baseball, or a series of action in the live event 18902. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live event 18902 in the future. Sportsbooks need to offer payment processing services in order to cash out customers. This can be done at kiosks at the live event 18902 or at another location.

Further, embodiments may include a plurality of sensors 18904 that may be used such as motion sensors, temperature sensors, humidity sensors, cameras such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices etc. Also, the plurality of sensors 18904 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 18906 or communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the Internet and relies on sharing of resources to achieve coherence and economics of scale, like a public utility, while third-party clouds allow organizations to focus on their core businesses instead of expending resources on computer infrastructure and maintenance. The cloud 18906 may be communicatively coupled to wagering network 18908 which may perform real time analysis on the type of play and the result of the play. The cloud 18906 may also be synchronized with game situational data, such as the time of the game, the score, location on the field, weather conditions, and the like which may affect the choice of play utilized. For example, in other exemplary embodiments, the cloud 18906 may not receive data gathered from sensors 18904 and may, instead, receive data from an alternative data feed, such as Sports Radar®. This data may be compiled substantially immediately following the completion of any play and the data from this feed may be compared with a variety of team data and league data based on a variety of elements, including down, possession, score, time, team, and so forth, as described in various exemplary embodiments herein.

Further, embodiments may include a wagering network 18908 which may perform real time analysis on the type of play and the result of a play or action. The wagering network 18908 (or cloud 18906) may also be synchronized with game situational data, such as the time of the game, the score, location on the field, weather conditions, and the like which may affect the choice of play utilized. For example, in other exemplary embodiments, wagering network 18908 may not receive data gathered from sensors 18904 and may, instead, receive data from an alternative data feed, such as Sports Radar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 18908 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may include a user database 18910 which contains data relevant to all users of the system, which may include, a user ID of the user, a device identifier for their mobile device 18928, a list of the players indicated as favorites by the user through the favorites module 18920, and could also include wagering history on the user, and other relevant user data.

Further, embodiments may include an odds calculation module 18912 which utilizes historical play data to calculate odds for in-play wagers.

Further, embodiments may include a historical plays database 18914, that contains play data for the type of sport being played in live event 18902. For example, in American football for optimal odds calculation, the historical play data should include meta data about the historical plays, such as time, location, weather, previous plays, opponent, physiological data, etc.

Further, embodiments may include an odds database 18916 that contains the odds calculated by the odds calculation module 18912 to display the odds the user's mobile device 18928 and to take bets from the user through the mobile device wagering app 18930.

Further, embodiments may include an event wager database 18918 which stores users wagers during a live event 18902 including time stamps for wagers placed on specific plays and including the results of the wager.

Further, embodiments may include a recording database 18920 which stores recordings of a live event 18902 either in its entirety or as individual plays occurring during the live event 18902.

Further, embodiments may include a base wagering module 18922 that allows the user to log into the wagering network 18908, view the selectable wagers, and make a wager, the base wagering module 18922 creates timestamps for the beginning and end of a play which are stored in the event wager database 18918, if the live event 18902 has ended the base wagering module 18922 initiates the wager review module 18924.

Further, embodiments may include a wager review module 18924 which inserts wager information into a video recording or video file of the live event 18902 in the recording database 18920 for each play based on the time stamps in the event wager database 18918.

Further, embodiments may include a clip database 18926 which stores the recordings of individual plays with the wagering information overlayed, in some embodiments this database may be on the user's mobile device 18928.

Further, embodiments may include a mobile device 18928 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices provides for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 18928 could be an optional component and would be utilized in a situation in which a paired wearable device is utilizing the mobile device 18928 as additional memory or computing power or connection to the internet.

Further, embodiments may include a wagering app 18930, which is a program that enables the user to place bets on individual plays in the live event 18902, and display the audio and video from the live event 18902, along with the available wagers on the mobile device 18928. The wagering app 18930 allows the user to interact with the wagering network 18908 in order to place bets and provide payment/receive funds based on wager outcomes.

FIG. 190 displays the event wager database 18918. The event wager database 18918 contains users' wagers during a live event 18902 including time stamps for wagers placed on specific plays and including the results of the wager. The database contains a user ID, for example, “bpatterson”, the selected wager option, for example, run, whether the wager was won or lost, a live event ID, for example, “08112020”, a play ID, for example, “12”, a start time for the play, for example, 34:58, and an end time for the play, for example, 37:13, in some embodiments the database may contain additional data such as wager amount, wager odds, etc.

FIG. 191 displays the recording database 18920. The recording database 18920 contains recordings or video files (or just files) of a live event 18902 either in its entirety or as individual plays occurring during the live event 18902. The database contains a live game ID, for example, “08112020” and a recording file, for example, “08112020.MP4” if the recordings are made for individual plays then the database will also contain a play ID, for example, “23”.

In further embodiments, it may be understood that the making or generating of a recording may not be performed and, instead, a video file which has already been created and may be stored in a database or otherwise linked, may be utilized in any of the embodiments. For example, a video file stored in another database may have utilize timestamps associated with a beginning and end of a play. Further, any polling or determining of a start and end portion of a play may be done without a new recording being generated, locally or otherwise.

FIG. 192 displays the base wagering module 18922. The process begins with the base wagering module 18922 being, at step 19200, initiated by user login via the wagering app 18930, login includes at least a user ID, in some embodiments login may include security credentials such as a password, for example user Bob Patterson is watching a baseball game and logs into the wagering app 18930 to make wagers, login includes at least a user ID, in some embodiments login may include security credentials such as a password. The base wagering module 18922 retrieves, at step 19202, the available wagers for the current play of the live event 18902 from the odds calculation module 18912, in an embodiment wagers and odds may be retrieved from a third party. The base wagering module 18922 displays, at step 19204, the available wagers for the current play and the associated odds for each wager, for example, user Bob Patterson is given the options to wager on if the next play will be a run or a pass, these options are displayed to Bob via the wagering app 18930. The base wagering module 18922 prompts, at step 19206, the user to select one of the available wagers, in an embodiment this selection process may be facilitated by a GUI within the wagering app 18930, for example, user Bob Patterson selects the option “Pass” by clicking on a button marked “Pass” on the wagering app 18930, then Bob is prompted to enter an amount to wager. The base wagering module 18922 receives, at step 19208, the user's selection of wager for the current play and the amount of money the user has wagered. The base wagering module 18922 creates, at step 19210, a timestamp of the beginning of the next play, in some embodiments this timestamp may be based on when the window for making a wager closes. The base wagering module 18922 polls, at step 19212, for completion of the current play of the live event 18902. The base wagering module 18922 creates, at step 19214, a timestamp of the end of the play, in some embodiments this timestamp may be based on when the window for making a wager on the next play opens. The base wagering module 18922 compares, at step 19216, the actual results of the play of the live event 18902 to the user's wager selection. The base wagering module 18922 stores, at step 19218, the user ID, wager selection, wager results, live game ID, play ID, and the two created timestamps in the event wager database 18918. The base wagering module 18922 adjusts, at step 19220, the user's balance in the user database 18910 based on whether the wager was won or lost, in an embodiment a third party will instead handle user balance and payments, for example if user Bob Patterson wagered that the next play was a pass and the next play was in fact a pass then Bob's balance will be increased based on the odds of the wager and the amount of money Bob chose to wager. The base wagering module 18922 determines, at step 19222, if the live event 18902 is complete via data from the sensor 18904, in some embodiments the end of the live event 18902 may be manually determined or determined by another module. If the live event 18902 is not complete, the base wagering module 18922 returns, at step 19224, to step 19202. If the live event 18902 is complete, the base wagering module 18922 initiates, at step 19226, the wager review module 18924 and sends the live event ID of the completed live event 18902. The base wagering module 18922 ends, at step 19228.

FIG. 193 displays the wager review module 18924. The process begins with the wager review module 18924 being, at step 19300, initiated by the base wagering module 18922 and receiving the live event ID of the completed live event 18902. The wager review module 18924 extracts, at step 19302, the recording of the live event 18902 from the recording database 18920. The wager review module 18924 searches, at step 19304, for entries in the event wager database 18918 that match the received live game ID, for example, if user Bob Patterson makes a wager during a football game, then the wager will be tied to the football game via the live game ID stored in the event wager database 18918. The wager review module 18924 extracts, at step 19306, the matching entries from the event wager database 18918. The wager review module 18924 selects, at step 19308, the first extracted entry, for example, the wager user Bob Patterson made on the 12th play of the game, The wager review module 18924 creates, at step 19310, a summary graphic using the data in the selected entry, the data is inserted into a graphical template which creates a graphic for the wager, in some embodiments more than one graphical template may exist and the wager review module 18924 may select one. The wager review module 18924 creates, at step 19312, a clip by copying a segment of the recording starting at the earlier timestamp and ending at the later timestamp, in an embodiment where recordings are stored for individual plays and not the entire live event 18902, this step may be skipped. The wager review module 18924 overlays, at step 19314, the created graphic onto the clip such that when that clip is viewed the viewer will see both the video and the graphic with the video behind the graphic, for example, user Bob Patterson made a wager on a play of a football game he is watching, the created clip will show the play he wagered on, and will have graphics overlayed that show that he wagered that the play would be a pass, that he won the wager, how much he wagered, how much he won, etc. The wager review module 18924 stores, at step 19316, the clip in the clip database 18926 along with the user ID and wager data. The wager review module 18924 determines, at step 19318, if there is another entry that was extracted from the event wager database 18918 but has not yet been selected by the wager review module 18924. If there is another entry, the wager review module 18924 selects, at step 19320, that entry and returns to step 19310. If there is not another entry, the wager review module 18924 returns, at step 19322, to the base wagering module 18922.

FIG. 194 illustrates the clip database 18926. The clip database 18926 stores the recordings of individual plays with the wagering information overlayed and includes a user ID, for example “bpatterson”, a video file or clip, for example, “1.MP4”, the selected wager option, for example, run, whether the wager was won or lost, a live event ID, for example, “08112020”, a play ID, for example, “12”. In an embodiment the user can name the clip before is stored in the clip database 18926 by the wager review module 18924.

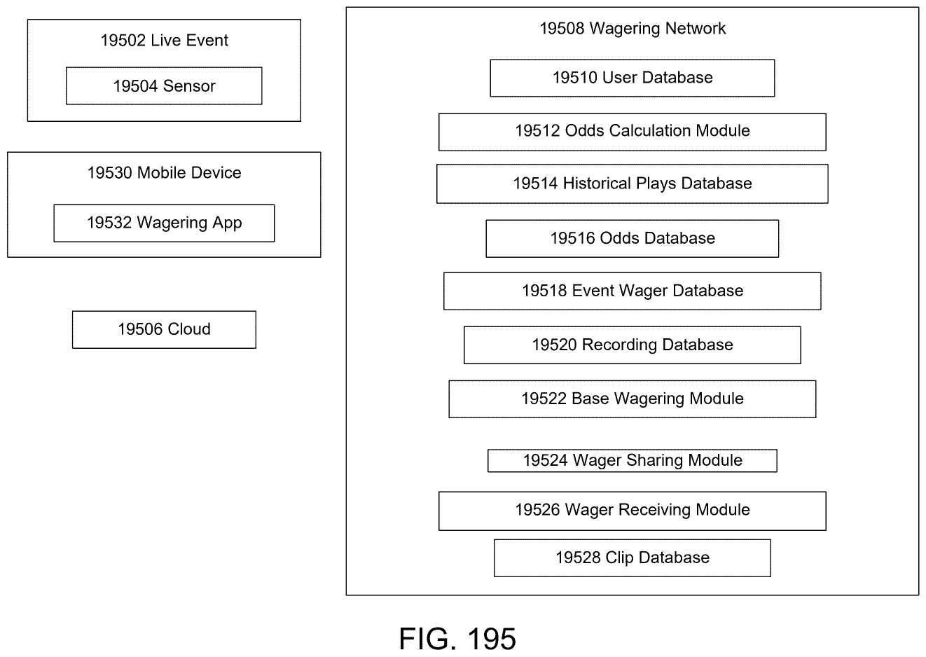

FIG. 195 illustrates a system for a wager replaying and sharing system, according to an embodiment.

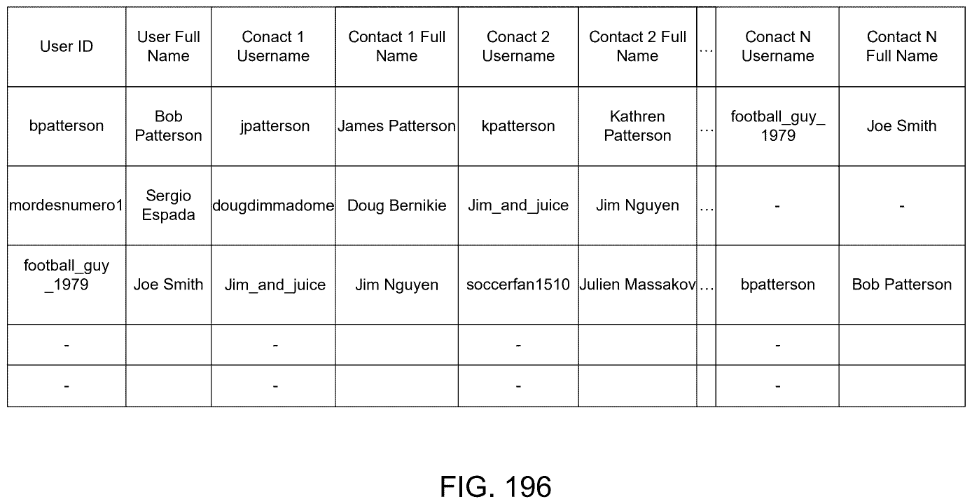

FIG. 196 illustrates a user database, according to an embodiment.

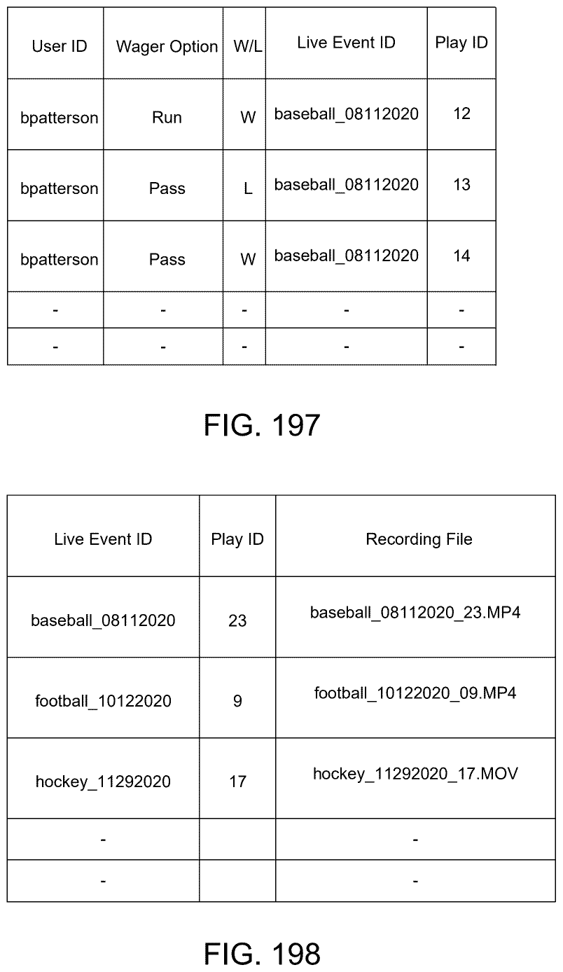

FIG. 197 illustrates an event wager database, according to an embodiment.

FIG. 198 illustrates a recording database, according to an embodiment.

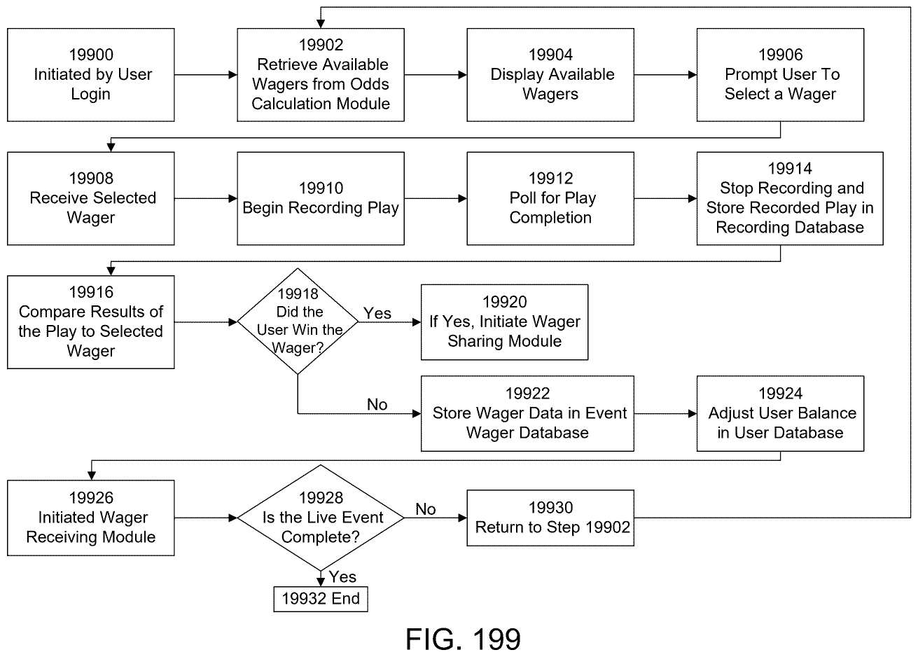

FIG. 199 illustrates a base wagering module, according to an embodiment.

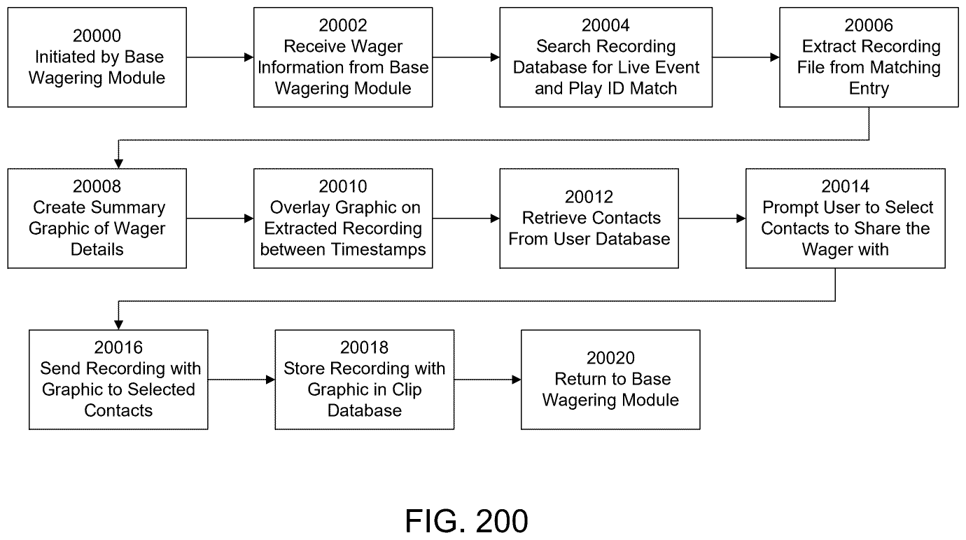

FIG. 200 illustrates a wager sharing module, according to an embodiment.

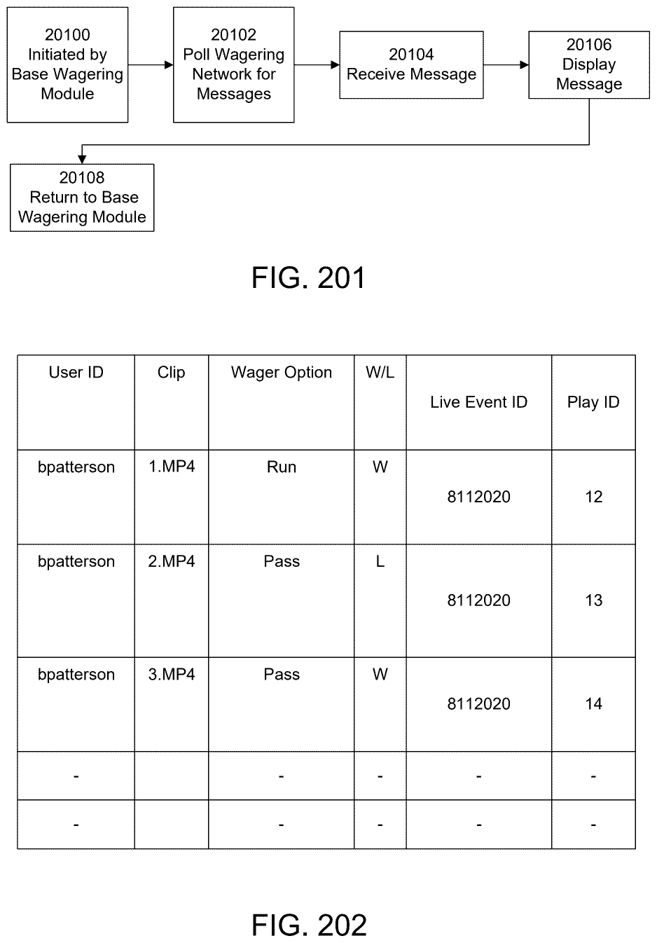

FIG. 201 illustrates a wager receiving module, according to an embodiment.

FIG. 202 illustrates a clip database, according to an embodiment.

FIG. 195 displays a system for a wager replaying and sharing system. This system may include a live event 19502, for example a sporting event such as a football game, basketball game, baseball game, hockey game, tennis match, golf tournament, eSports or digital game, etc. The live event 19502 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 19502, such as the score of American football or the run line in baseball, or a series of action in the live event 19502. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events 19502 in the future. Sportsbooks need to offer payment processing services in order to cash out customers. This can be done at kiosks at the live event 19502 or at another location.

Further, embodiments may include a plurality of sensors 19504 that may be used such as motion sensors, temperature sensors, humidity sensors, cameras such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices etc. Also, the plurality of sensors 19504 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 19506 or communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the Internet and relies on sharing of resources to achieve coherence and economics of scale, like a public utility, while third-party clouds allow organizations to focus on their core businesses instead of expending resources on computer infrastructure and maintenance. The cloud 19506 may be communicatively coupled to wagering network 19508 which may perform real time analysis on the type of play and the result of the play. The cloud 19506 may also be synchronized with game situational data, such as the time of the game, the score, location on the field, weather conditions, and the like which may affect the choice of play utilized. For example, in other exemplary embodiments, the cloud 19506 may not receive data gathered from sensors 19504 and may, instead, receive data from an alternative data feed, such as Sports Radar®. This data may be compiled substantially immediately following the completion of any play and the data from this feed may be compared with a variety of team data and league data based on a variety of elements, including down, possession, score, time, team, and so forth, as described in various exemplary embodiments herein.

Further, embodiments may include a wagering network 19508 which may perform real time analysis on the type of play and the result of a play or action. The wagering network 19508 (or cloud 19506) may also be synchronized with game situational data, such as the time of the game, the score, location on the field, weather conditions, and the like which may affect the choice of play utilized. For example, in other exemplary embodiments, wagering network 19508 may not receive data gathered from sensors 19504 and may, instead, receive data from an alternative data feed, such as Sports Radar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 19508 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may include a user database 19510 which contains data relevant to all users of the system, which may include, a user ID of the user, a device identifier for their mobile device 19530, a list of the players indicated as favorites by the user through the favorites module 19520, and could 19506 also include wagering history on the user, contacts which are used by the wager sharing module 19524 to send wager invitations to, and other relevant user data.

Further, embodiments may include an odds calculation mritodule 19512 which utilizes historical play data to calculate odds for in-play wagers.

Further, embodiments may include a historical plays database 19514, that contains play data for the type of sport being played in live event 19502. For example, in American football for optimal odds calculation, the historical play data should include meta data about the historical plays, such as time, location, weather, previous plays, opponent, physiological data, etc.

Further, embodiments may include an odds database 19516 that contains the odds calculated by the odds calculation module 19512 to display the odds the user's mobile device 19530 and to take bets from the user through the mobile device 19530 wagering app 19532.

Further, embodiments may include an event wager database 19518 which stores users wagers during a live event 19502 including wagers placed on specific plays and including the results of the wager.

Further, embodiments may include a recording database 19520 which stores recordings of a live event 19502 as individual plays occurring during the live event 19502.

Further, embodiments may include a base wagering module 19522 that allows the user to log into the wagering network 19508, view the selectable wagers, and make a wager, the base wagering module 19522 creates timestamps for the beginning and end of a play which are stored in the event wager database 19518, if the user wins the wager the base wagering module 19522 initiates the wager sharing module 19524, then initiates the wager receiving module 19526.

Further, embodiments may include a wager sharing module 19524 which allows users to share successful wagers with their contacts in the user database 19510.

Further, embodiments may include a wager receiving module 19526 which allows users to receive successful wagers that have been shared with them by other users.

Further, embodiments may include a clip database 19528 which stores the recordings of individual plays with the wagering information overlayed, in some embodiments this database may be on the user's mobile device 19530.

Further, embodiments may include a mobile device 19530 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allows for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 19530 could be an optional component and would be utilized in a situation in which a paired wearable device is utilizing the mobile device 19530 as additional memory or computing power or connection to the internet.

Further, embodiments may include a wagering app 19532, which is a program that enables the user to place bets on individual plays in the live event 19502, and display the audio and video from the live event 19502, along with the available wagers on the mobile device 19530. The wagering app 19532 allows the user to interact with the wagering network 19508 in order to place bets and provide payment/receive funds based on wager outcomes.

FIG. 196 displays the user database 19510. The user database 19510 contains data relevant to all users of the system and contains at least a user ID for each user and the user IDs of that user's contacts, for example user Bob Patterson has the user ID bpatterson, in his contacts he has jpatterson, the user ID for his son James Patterson, kpatterson, the user ID for his wife Kathren Patterson, football_guy_1979, the user ID for his friend Joc Smith, etc., in some embodiments the user database 19510 may contain a user ID of the user, a device identifier for their mobile device 19530, a list of the players indicated as favorites by the user through the favorites module 19520, and could also include wagering history on the user.

FIG. 197 displays the event wager database 19518. The event wager database 19518 contains users wagers during a live event 19502 including time stamps for wagers placed on specific plays and including the results of the wager. The database contains a user ID, for example, “bpatterson”, the selected wager option, for example, run, whether the wager was won or lost, a live event ID, for example, “baseball_08112020”, a play ID, for example, “12”, in some embodiments the database may contain additional data such as wager amount, wager odds, etc.4

FIG. 198 displays the recording database 19520. The recording database 19520 contains recordings of a live event 19502 either in its entirety or as individual plays occurring during the live event 19502. The database contains a live event ID, for example, a baseball game recorded on Aug. 11, 2020 could have a live event ID such as “baseball_08112020”, a play ID, for example, the 23rd play of the game, or at least the 23rd play on which a wager may be placed, would have a play ID of “23”, and a recording file, for example, the recording file for the 23rd play of the baseball game on Aug. 11, 2020 may be titled “baseball_08112020_23.MP4”0.5

FIG. 199 displays the base wagering module 19522. The process begins with the base wagering module 19522 being, at step 19900, initiated by user login via the wagering app 19532, for example user Bob is watching a baseball game on Aug. 11, 2020 and logs into the wagering app 19532 to make wagers, the login includes at least a user ID, in some embodiments the login may include security credentials such as a password. The base wagering module 19522 retrieves, at step 19902, the available wagers for the current play of the live event 19502 from the odds calculation module 19512, in an embodiment wagers and odds may be retrieved from a third party. The base wagering module 19522 displays, at step 19904, the available wagers for the current play and the associated odds for each wager. The base wagering module 19522 prompts, at step 19906, the user to select one of the available wagers, for example, user Bob can wager that the next play will be a strike or home run, in an embodiment this selection process may be facilitated by a GUI within the wagering app 19532. The base wagering module 19522 receives, at step 19908, the user's selection of wager for the current play and the amount of money the user has wagered. The base wagering module 19522 begins, at step 19910, to record the play of the live game 19502. The base wagering module 19522 polls, at step 19912, for completion of the current play of the live event 19502. The base wagering module 19522 stops, at step 19914, recording the play and stores the created record in the recording database 19520. The base wagering module 19522 compares, at step 19916, the actual results of the play of the live event 19502 to the user's wager selection. The base wagering module 19522 determines, at step 19918, if the user won the wager based on the comparison of the results to the selected wager, if the user did not win the wager, the base wagering module 19522 skips to step 19922. If the user won the wager, the base wagering module 19522 initiates, at step 19920, the wager sharing module 19524 and sends the wager information. The base wagering module 19522 stores, at step 19922, the user ID, wager selection, wager results, live game ID, and play ID, in the event wager database 19518. The base wagering module 19522 adjusts, at step 19924, the user's balance in the user database 19510 based on whether the wager was won or lost, in an embodiment a third party will instead handle user balance and payments. The base wagering module 19522 initiates, at step 19926, the wager receiving module 19526. The base wagering module 19522 determines, at step 19928, if the live event 19502 is complete via data from the sensor 19504, in some embodiments the end of the live event 19502 may be manually determined or determined by another module. If the live event 19502 is not complete, the base wagering module 19522 returns, at step 19930, to step 19902. If the live event 19502 is complete, the base wagering module 19522 ends, at step 19932.

In further embodiments, it may be understood that the making or generating of a recording may not be performed and, instead, a video file which has already been created and may be stored in a database or otherwise linked, may be utilized in any of the embodiments. For example, a video file stored in another database may have utilize timestamps associated with a beginning and end of a play. Further, any polling or determining of a start and end portion of a play may be done without a new recording being generated, locally or otherwise.

FIG. 200 displays the wager sharing module 19524. The process begins with the wager sharing module 19524 being, at step 20000, initiated by the base wagering module 19522. The wager sharing module 19524 receives, at step 20002, wager information from the base wagering module 19522. The wager sharing module 19524 searches, at step 20004, for an entry in the recording database 19520 that matches the received live event ID and play ID. The wager sharing module 19524 extracts, at step 20008, the recording file from the matching entry. The wager sharing module 19524 creates, at step 20010, a summary graphic using the received wager information, the data is inserted into a graphical template which creates a graphic for the wager, in some embodiments more than one graphical template may exist and the wager sharing module 19524 may select one. The wager sharing module 19524 overlays, at step 20012, the created graphic onto the recording such that the viewer will see both the video and the graphic with the video behind the graphic. The wager sharing module 19524 retrieves, at step 20014, contacts for the user from the user database 19510. The wager sharing module 19524 prompts, at step 20016, the user to select which contacts they want to share the wager and play with, for example user Bob can select from any of his contacts in the user database 19510 like his son James Patterson who has the user Id “jpatterson”, in some embodiments this selection may be facilitated by a GUI. The wager sharing module 19524 sends, at step 20018, the recording with the created graphical overlay to the selected contacts. The wager sharing module 19524 returns, at step 20020, to the base wagering module 19522.

FIG. 201 displays the wager receiving module 19526. The process begins with the wager receiving module 19526 being, at step 20100, initiated by the base wagering module 19522. The wager receiving module 19526 polls, at step 20102, for messages from the wagering network 19508, for example, video files send by the wager sharing module 19524. The wager receiving module 19526 receives, at step 20104, the message or messages from the wagering network 19508, for example user Bob Patterson receives a message from his friend Joe Smith delivered via the wagering network 19508. The wager receiving module 19526 displays, at step 20106, the received messages to the user via the user's wagering app 19532, for example user Bob Patterson looks at his message from his friend Joe Smith, the message is a video file of a play from the baseball game both Bob and Joe are watching, Bob sees the recording of the play with information about Joe's wager overlayed. The wager receiving module 19526 returns, at step 20108, to the base wagering module 19522.

FIG. 202 displays the clip database 19528. The clip database 19528 stores the recordings of individual plays with the wagering information overlayed and includes a user ID, for example “bpatterson”, a video file or clip, for example, “1.MP4”, the selected wager option, for example, run, whether the wager was won or lost, a live event ID, for example, “08112020”, a play ID, for example, “12”. In an embodiment the user can name the clip before is stored in the clip database 19528 by the wager sharing module 19524.

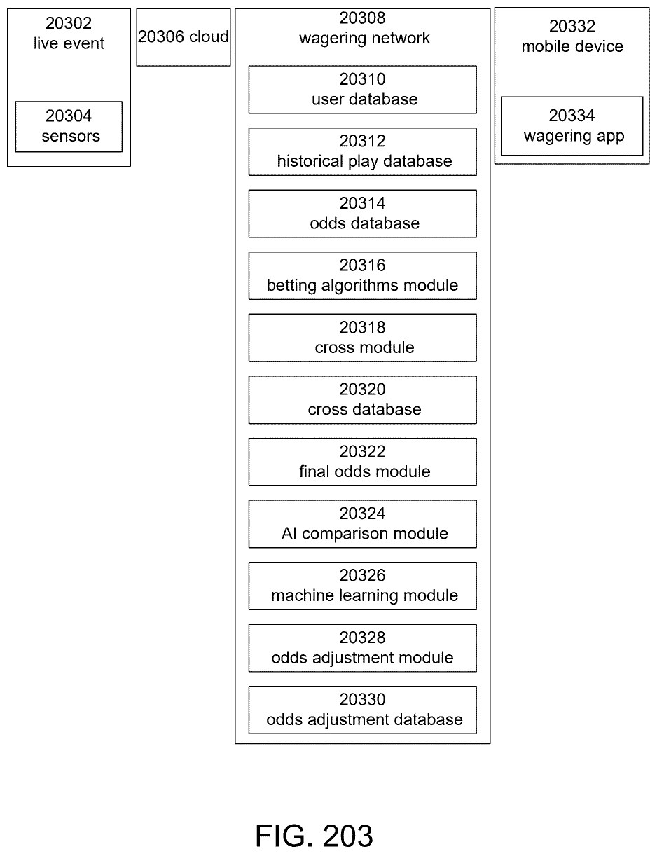

FIG. 203: Illustrates a method of displaying a notification from a betting application using AI that can impact normal betting, according to an embodiment.

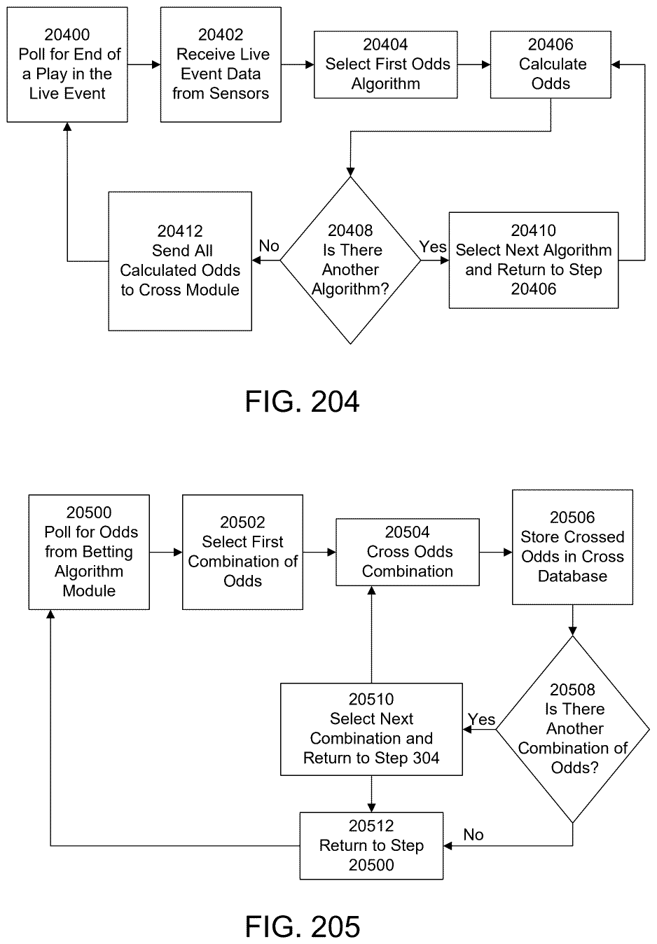

FIG. 204: Illustrates a betting algorithms module, according to an embodiment.

FIG. 205: Illustrates a cross module, according to an embodiment.

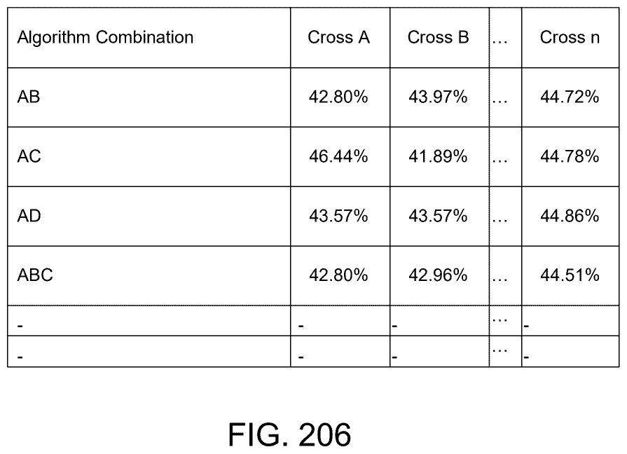

FIG. 206: Illustrates a cross database, according to an embodiment.

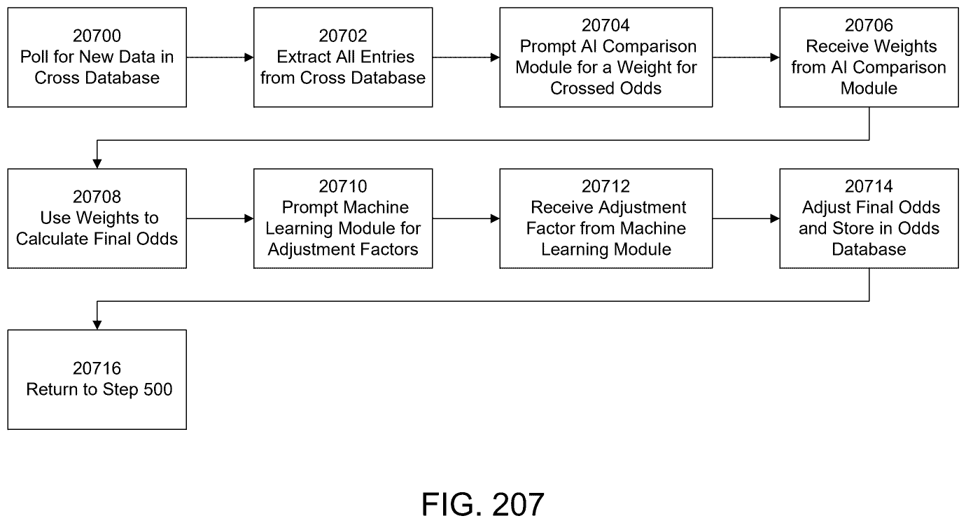

FIG. 207: Illustrates a final odds module, according to an embodiment.

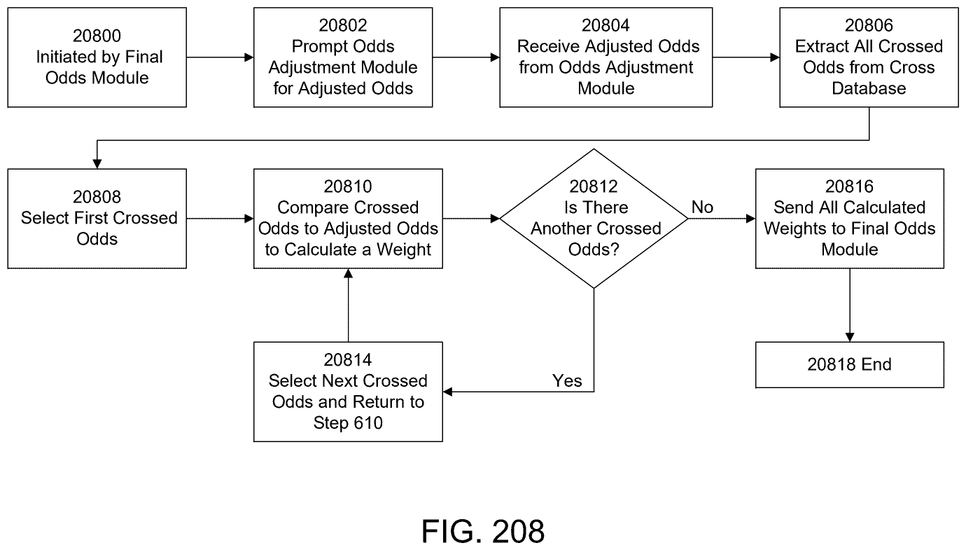

FIG. 208: Illustrates an AI comparison module, according to an embodiment.

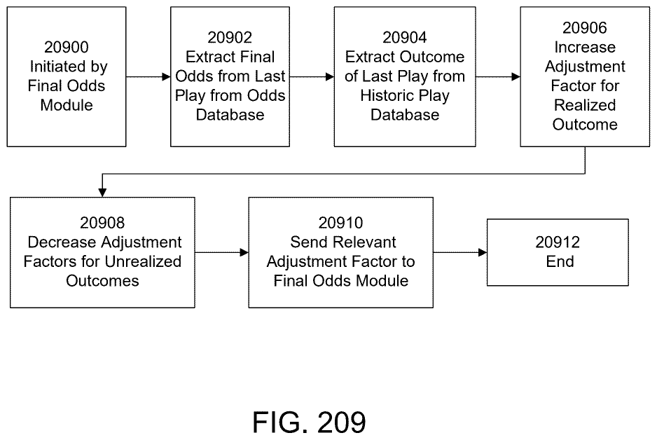

FIG. 209: Illustrates a machine learning module, according to an embodiment.

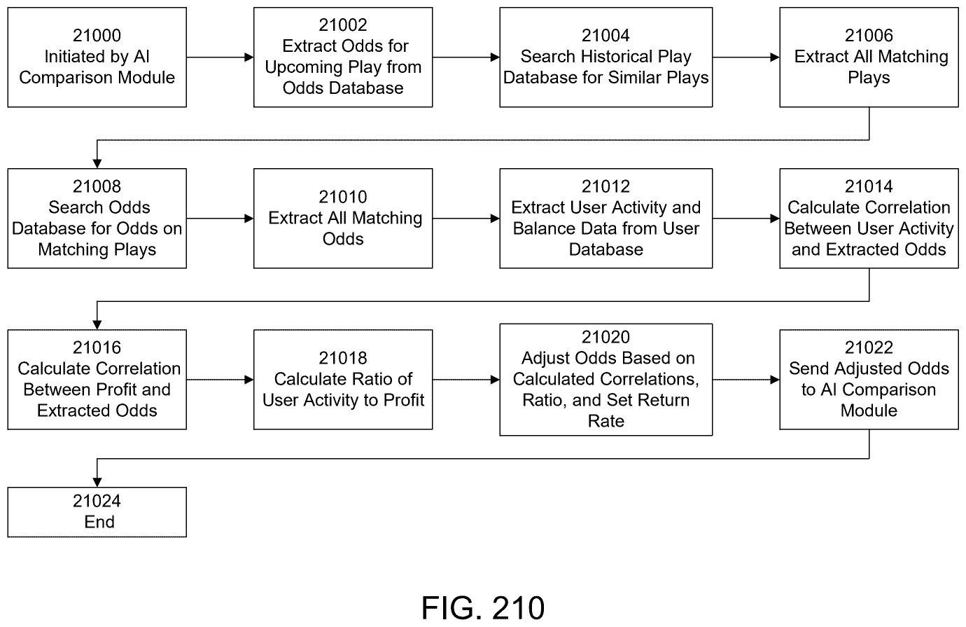

FIG. 210: Illustrates an odds adjustment module, according to an embodiment.

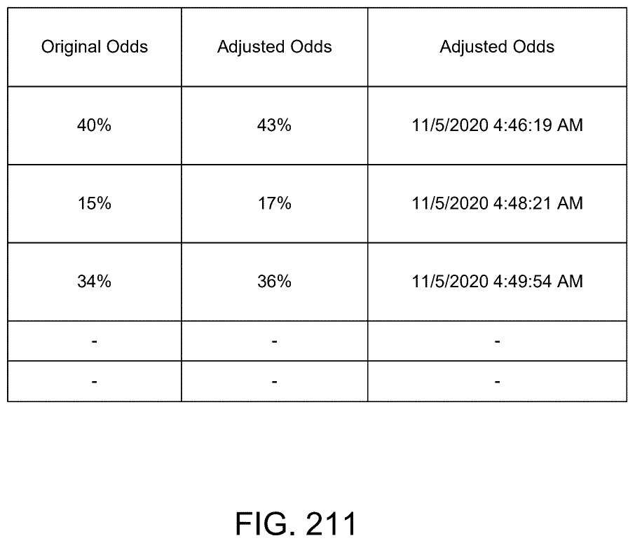

FIG. 211: Illustrates an odds adjustment database, according to an embodiment.

FIG. 203 displays a system for a method of displaying a notification from a betting application using AI that can impact normal betting. This system is comprised of a live event 20302, for example a sporting event such as a football game, basketball game, baseball game, hockey game, tennis match, golf tournament, eSports or digital game, etc. The live event 20302 will include some number of actions or plays, upon which a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game was the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets, that are added games, that may allow the user to customize their betting by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 20302, such as the score of American football or the run line in baseball, or a series of action in the live event 20302. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live event 20302 in the future. Sportsbooks need to offer payment processing services in order to cash out customers. This can be done at kiosks at the live event 20302 or at another location.

Further, embodiments may include a plurality of sensors 20304 that may be used such as motion sensors, temperature sensors, humidity sensors, cameras such as an RGB-D Camera which is a digital camera capturing color (RGB) and depth information for every pixel in an image, microphones, a radiofrequency receiver, a thermal imager, a radar device, a lidar device, an ultrasound device, a speaker, wearable devices etc. Also, the plurality of sensors 20304 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball.

Further, embodiments may include a cloud 20306 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, such as over Internet, and relies on sharing of resources to achieve coherence and economies of scale, like a public utility, while third-party clouds enable organizations to focus on their core businesses instead of expending resources on computer infrastructure and maintenance. The cloud 20306 may be communicatively coupled to a wagering network 20308 which may perform real time analysis on the type of play and the result of the play. The cloud 20306 may also be synchronized with game situational data, such as the time of the game, the score, location on the field, weather conditions, and the like which may affect the choice of play utilized. For example, in some exemplary embodiments, the cloud 20306 may not receive data gathered from the plurality of sensors 20304 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein.

Further, embodiments may include the wagering network 20308 which may perform real time analysis on the type of play and the result of a play or action. The wagering network 20308 (or cloud 20306) may also be synchronized with game situational data, such as the time of the game, the score, location on the field, weather conditions, and the like which may affect the choice of play utilized. For example, in some exemplary embodiments, the wagering network 20308 may not receive data gathered from the plurality of sensors 20304 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 20308 may offer a number of software as a service managed services such as, user interface service, risk management service, compliance, pricing and trading service, IT support of the technology platform, business applications, game configuration, state based integration, fantasy sports connection, integration to allow the joining of social media, and marketing support services that can deliver engaging promotions to the user.

Further, embodiments may utilize a user database 20310 which contains data relevant to all users of the system, which may include, a user ID, a device identifier, a paired device identifier, wagering history, and wallet information for each user.

Further, embodiments may include a historical play database 20312, that contains play data for the type of sport being played in the live event 20302. For example, in American Football, for optimal odds calculation, the historical play data should include meta data about the historical plays, such as time, location, weather, previous plays, opponent, physiological data, etc.

Further, embodiments may utilize an odds database 20314 that contains the odds calculated by the odds calculation module, and the multipliers for distance and path deviation, and is used for reference by the base wagering module 20318 and to take bets from the user through a user interface and calculate the payouts to the user.

Further, embodiments may utilize a betting algorithms module 20316 that calculates odds for the next play of the live event 20302 using a number of different known algorithms, then sends the odds calculated by each algorithm to a cross module 20318. Further, embodiments may utilize the cross module 20318 which combines the odds received from the betting algorithms module 20316 in every possible combination, for example, if there are 5 different odds generated from 5 different algorithms, the cross module 20318 will calculate the combinations for 1 and 2, 1 and 3, 1 and 4, 1 and 5, 1, 2, and 3, etc. These combinations are then stored in a cross database 20320. Further, embodiments may utilize a cross database 20320 which contains all the combinations of odds calculated by the cross module 20318 for the current play of the live event 20302.

Further, embodiments may utilize a final odds module 20322 which uses the odds stored in the cross database 20320 and the odds stored in the odds database 20314 to create the final odds for a play. The final odds module 20322 prompts an AI comparison module 20324 to determine how all of the calculated odds should be used in determining the final odds.

Further, embodiments may utilize the AI comparison module 20324 which prompts an odds adjustment module 20328 to adjust the odds stored in the odds database 20314, then compares each of the odds in the cross database 20320 to determine the accuracy of the odds generated by the cross module 20318.

Further, embodiments may utilize a machine learning module 20326 which determine how the historically generated final odds match the actual historical outcomes of plays. This data may be used to enhance the accuracy of the final odds module 20322. Further, embodiments may utilize the odds adjustment module 20328 which adjusts the odds in order to maximize user interest while also accounting for risk of loss. The odds adjustment module 20328 estimates profit increase due to increased user interest and compares that value to expected loss and adjusts the odds accordingly in order to maximize the ratio of profit return.

Further, embodiments may utilize an odds adjustment database 20330 which stores the odds adjustment made by the odds adjustment module 20328 along with a timestamp.

Further, embodiments may include a mobile device 20332 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WII, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices provide for voice recognition and inputs, including, e.g., Microsoft KINECT, SIRI for IPHONE by Apple, Google Now or Google Voice Search. Additional user devices may have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 20332 could be an optional component and may be utilized in a situation in which a paired wearable device is utilizing the mobile device 20332 as additional memory or computing power or as a connection to the internet.

Further, embodiments may include a wagering app 20334, which is a program that enables the user to place bets on individual plays in the live event 20302, and display the audio and video from the live event 20302, along with the available wagers on the mobile device 20332. The wagering app 20334 allows the user to interact with the wagering network 20308 in order to place bets and provide payment/receive funds based on wager outcomes.

FIG. 204 displays the betting algorithms module 20316. The process begins with the betting algorithms module 20316 polling, at step 20400, for the end of a play of the live event 20302 via the plurality of sensors 20304, or any other event which would be followed by a play such as the beginning of the game or the end of a time-out. The betting algorithms module 20316 receives, at step 20402, data about the current state of the live event 20302 from the plurality of sensors 20304. For example, the live event 20302 features the Minnesota Vikings against the Green Bay Packers, the Packers are on offense, it is 1st and 10 and 7 minutes from half-time, and the weather is 6 mph winds. The betting algorithms module 20316 selects, at step 20404, a first betting odds algorithm. These algorithms are each part of the betting algorithms module 20316, in some embodiments the algorithms may be stored in a database and retrieved. Algorithms could be, for example, a series of steps, or even an entire separate module, designed to find profitable sports betting opportunities. They use vast amounts of data from past sporting matches so as to identify patterns, which can then be used to calculate the probability of certain sporting outcomes. Example algorithms include betting arbitrage, betting bank, unit stakes, Kelly's Criterion, and Monte Carlo. The betting algorithms module 20316 calculates, at step 20406, odds for the upcoming play of the live event 20302 based on the selected algorithm. For example, algorithm A may calculate that the odds of the next play being a pass are 42.4% while algorithm B calculates the odds at 46.7%. In embodiments where the algorithm is itself a separate module the betting algorithms module 20316 receives the odds instead. The betting algorithms module 20316 determines, at step 20408, if there is another algorithm that has not yet been used to calculate odds for this upcoming play. If there is another algorithm, the betting algorithms module 20316 selects, at step 20410, the next algorithm and returns to step 20406. If there are no other algorithms, the betting algorithms module 20316 sends, at step 20412, all calculated odds to the cross module 20318, then returns to step 20400.

FIG. 205 displays the cross module 20318. The process begins with the cross module 20318 polling, at step 20500, for a set of odds from the betting algorithm module, each separate odds being generated by a different algorithm. The cross module 20318 selects, at step 20502, the first combination of odds, for example if there are five different odds received from the betting algorithm module, then the first combination would be the first and second odds. The cross module 20318 crosses, at step 20504, the combination of odds. Crossing odds is a mathematical process by which odds are combined via different methods, for example, the mean of the combination of odds, the median of the combination of odds, the mode of the combination of odds, etc. Crossing odds then results in multiple crossed odds outputs. For example, if we cross the odds 20%, 30%, and 50%, the results would be 33.3% for the average, but 30% for the median. The cross module 20318 stores, at step 20506, all the resulting crossed odds in the cross database 20320 along with the combination and method of crossing. For example, the odds from algorithm A and algorithm B are crossed by crossing method A for a result of 42.80%, and crossing method B for a result of 43.97%. These results are stored in the cross database 20320. The cross module 20318 determines, at step 20508, if there is another combination of odds that has not yet been crossed. If there is another combination of odds, the cross module 20318 selects, at step 20510, the next combination of odds and returns to step 20504. If there are no other combinations of odds, the cross module 20318 returns, at step 20612, to step 20500.

FIG. 206 displays the cross database 20320. The cross database 20320 contains all the combinations of odds calculated by the cross module 20318 for the current play of the live event 20302. Each entry contains an algorithm combination, for example, “AB” which denotes the combination of odds generated by those algorithms, and the result of each different cross. Cross A may be, for example, the mean value of the odds, whereas cross B may be the median value. In some embodiments the cross database 20320 may also contain identifiers for the outcome the odds are predicting, such as pass or run, and identifiers for which play and live event 20302 the odds correspond to. In some embodiments the cross database 20320 may be purged with each new play of a live event 20302.

FIG. 207 displays the final odds module 20322. The process begins with the final odds module 20322 polling, at step 20700, for new data in the cross database 20320. The final odds module 20322 extracts, at step 20702, all entries from the cross database 20320. In embodiments where the cross database 20320 contains crossed odds from multiple plays the final odds module 20322 may extract only the entries that predict the odds for the upcoming play of the live event 20302. The final odds module 20322 prompts, at step 20704, the AI comparison module 20324 for a weight for each crossed odds, meaning the odds from each unique combination of algorithms and crossing method. The final odds module 20322 receives, at step 20706, a set of weights from the AI comparison module 20324 corresponding to each crossed odds. The final odds module 20322 calculates, at step 20708, the final odds by taking a weighted average of all crossed odds. For example, the odds from algorithms A and B crossed by method A, 42.80%, is given a weight of 0.9 while the odds from the algorithms A and B crossed by method B, 43.97%, is given a weight of 0.6. The odds from algorithm A and B crossed by method A are multiplied by the weight 0.9, and the odds from the algorithm A and B crossed by method B are multiplied by 0.6, the two resulting values are divided by the sum of all weights, resulting in odds of 43.27%. The final odds module 20322 prompts, at step 20710, the machine learning module 20326 for an adjustment factor which is based on the historical accuracy of the final odds module 20322. The final odds module 20322 receives, at step 20712, an adjustment factor from the machine learning module 20326. The final odds module 20322 adjusts, at step 20714, the final odds based on the adjustment factor and then stores the final odds in the odds database 20314. For example, the machine learning module 20326 determines that the final odds predicted passes at a 2% higher rate than the actual number of passes based on historical data, resulting in an adjustment factor of 0.98. The weighted average, 43.27%, is multiplied by 0.98 resulting in final odds for the next play being a pass of 42.40%. In some embodiments the final odds may be stored separately from the historical odds in the odds database 20314, in other embodiments the final odds will overwrite the odds already in the odds database 20314. The final odds module 20322 returns, at step 20716, to step 20700. In some embodiments the final odds module 20322 may poll for play completion before returning to step 20700.

FIG. 208 displays the AI comparison module 20324. The process begins with the AI comparison module 20324 being, at step 20800, initiated by the final odds module 20322. The AI comparison module 20324 prompts, at step 20802, the odds adjustment module 20328 for the original odds stored in the odds database 20314 which are then adjusted to optimize both profit and user satisfaction. The AI comparison module 20324 receives, at step 20804, the adjusted odds from the odds adjustment module 20328. The AI comparison module 20324 extracts, at step 20806, all crossed odds from the crossed database 20320. In embodiments where crossed odds for more than one play are stored in the cross database 20320 only crossed odds for the upcoming play of the live event 20302 will be extracted. The AI comparison module 20324 selects, at step 20808, the first crossed odds of the extracted crossed odds. The AI comparison module 20324 compares, at step 20810, the selected crossed odds with the adjusted odds and determines a weight based on the difference. For example, the weight may be the ratio of the lesser odds divided by the greater odds or the adjusted odds divided by the absolute value of the difference between the crossed odd and the adjusted odds. The AI comparison module 20324 determines, at step 20812, if there is another crossed odd that a weight has not yet been calculated for. If there is another crossed odd, the AI comparison module 20324 selects, at step 20814, the next crossed odds and returns to step 20810. If there are no more crossed odds, the AI comparison module 20324 sends, at step 20816, the calculated weights for each crossed odds to the final odds module 20322. The AI comparison module 20324 ends, at step 20818.

FIG. 209 displays the machine learning module 20326. The process begins with the machine learning module 20326 being, at step 20900, initiated by the final odds module 20322. The machine learning module 20326 extracts, at step 20902, the final odds for the last play of the live event 20302 from the odds database 20314. The machine learning module 20326 extracts, at step 20904, the outcome of the last play of the live event 20302 from the historic play database 20312. The machine learning module 20326 increases, at step 20906, the adjustment factor for the realized outcome. For example, if the realized outcome is a pass, the adjustment factor for odds for a pass will be increased. Adjustment factors begin at 1 and are changed and saved with each iteration of the machine learning module 20326. The machine learning module 20326 decreases, at step 20908, the adjustment factors for the unrealized outcomes. For example, if the realized outcome is a pass, the adjustment factor for odds for a run will be decreased. Adjustment factors begin at 1 and are changed and saved with each iteration of the machine learning module 20326. The machine learning module 20326 sends, at step 20910, the relevant adjustment factor to the final odds module 20322. For example, if the final odds module 20322 is only calculating the odds of a pass, then only the adjustment factor for pass odds will be sent. In some embodiments all adjustment factors may be sent and the final odds module 20322 will determine which to use. The machine learning module 20326 ends at step 20912.

FIG. 210 displays the odds adjustment module 20328. The process begins with the odds adjustment module 20328 being, at step 21000, initiated by the AI comparison module 20324. The odds adjustment module 20328 extracts, at step 21002, the odds for the upcoming play of the live event 20302 from the odds database 20314. The odds adjustment module 20328 searches, at step 21004, the historical play database 20312 for plays with similar parameters to the upcoming play of the live event 20302. A play does not need to match all of the parameters of the current state of the live event 20302 in order to be similar, for example, a similar play may be one in which the same teams are playing but the wind speed is within 5 mph of the current wind speed, or a play wherein the same team is on offense but a different team is on defense. In some embodiments the criteria for which plays are similar is dynamic and may be determined by a machine learning algorithm. The odds adjustment module 20328 extracts, at step 21004, data on all plays that are similar to the current state of the live event 20302. The odds adjustment module 20328 searches, at step 21008, the odds database 20314 for the odds given to users on all of the extracted plays from the historical play database 20312. In some embodiments different odds may be given to different users for the same play, which would increase the accuracy of the correlations calculated in steps 21014 and 21016. The odds adjustment module 20328 extracts, at step 21010, all of the matching odds in the odds database 20314. The odds adjustment module 20328 extracts, at step 21012, all data on user activity and user account balance from the user database 20310. User activity is the number of bets users place over a given time period such as a week, month, year, or duration of a live event 20302. In some embodiments user activity may also include the amount bet, or non-betting activity such as time spent on the wagering app 20334. Net changes in user balance in the negative will correspond with profit. In some embodiments profit may be retrieved directly from another database. In some embodiments incentives such as free or discounted credits or wagers may need to be considered in order to accurately assess profit from net user balance changes. The odds adjustment module 20328 calculates, at step 21014, a correlation coefficient between the extracted odds and user activity. For example, odds with better returns on plays that are similar would be expected to increase user activity because users would be enticed to make a bet on favorable odds. In some embodiments the correlation may be determined by linear correlation, in other embodiments the correlation may be non-linear. Correlation may be calculated using scatter diagram method, Karl Pearson's method, Spearman's rank method, least square method, or any other method known in the art, or any combination of methods. For example, the current play of the live event 20302 features the Minnesota Vikings against the Green Bay Packers, the Packers are on offense, it is 1st and 10 and 7 minutes from half-time, and the weather is 6 mph winds. These conditions are similar to other historical plays. The odds given to users for each of the similar historical plays is compared to the user activity level for each play. Using Karl Pearson's method to find a linear correlation coefficient results in a correlation coefficient of 0.85, meaning the odds given and the user activity level are highly correlated. In a second example, the current play of the live event 20302 features the Minnesota Vikings against the Green Bay Packers, the Packers are on offense, it is 3rd and 12 and 3 minutes from the start of the game, and the weather is light rain with no wind. These conditions are similar to other historical plays. The odds given to users for each of the similar historical plays is compared to the user activity level for each play. Using Karl Pearson's method to find a linear correlation coefficient results in a correlation coefficient of 0.15, meaning the odds given and the user activity level are not highly correlated. The odds adjustment module 20328 calculates, at step 21016, a correlation coefficient between the extracted odds and loss of user account balance, which would translate to overall profit by the system. For example, odds with better returns on plays that are similar would be expected to increase user account balance because users would be winning more money on average on more favorable odds. In some embodiments the correlation may be determined by linear correlation, in other embodiments the correlation may be non-linear. Correlation may be calculated using scatter diagram method, Karl Pearson's method, Spearman's rank method, least square method, any other method known in the art, or any combination of methods. For example, the current play of the live event 20302 features the Minnesota Vikings against the Green Bay Packers, the Packers are on offense, it is 1st and 10 and 7 minutes from half-time, and the weather is 6 mph winds. These conditions are similar to other historical plays. The odds given to users for each of the similar historical plays is compared to the profit for each play. Using Karl Pearson's method to find a linear correlation coefficient results in a correlation coefficient of −0.92, meaning the odds given and profit are highly correlated. In a second example, the current play of the live event 20302 features the Minnesota Vikings against the Green Bay Packers, the Packers are on offense, it is 3rd and 12 and 3 minutes from the start of the game, and the weather is light rain with no wind. These conditions are similar to other historical plays. The odds given to users for each of the similar historical plays is compared to the user activity level for each play. Using Karl Pearson's method to find a linear correlation coefficient results in a correlation coefficient of −0.28, meaning the odds given and the profit are not highly correlated. The odds adjustment module 20328 calculates, at step 21018, the ratio of user activity to profit by comparing loss of user account balance to user activity level. For example, each month an average of 100,000 users place an average of 2,000,000 bets and on average the net profit for each month is $6,000,000. Using these numbers results in a ratio of user activity to profit of $3 per user per month. This ratio can then be used to determine when it can be valuable to take a loss in exchange for user activity, for example, if the system could get 100 new users at a cost of $600 the estimated time to earn back that cost would be two months assuming the users continue to use the system. In some embodiments this may use the same method as the previous two steps to instead find correlation. The odds adjustment module 20328 adjusts, at step 21020, the extracted odds for the upcoming play of the live event 20302. The odds are adjusted based on a calculation that considers the correlation between profit and odds, the correlation between user activity and odds, the ratio of user activity to profit, and a set return rate. The return rate is the rate at which the administrators of the system are willing to lose profit in the short term for more profit in the long term. For example, if the return rate is 10% per year then the odds adjustment module 20328 will adjust the odds to be more favorable to the user such that the amount of profit lost will be returned with a 10% increase over the next year due to increased user activity. If the correlation between odds and user activity is 0.85, and the correlation between odds and profit is −0.92, then increasing the odds will result in more user activity but less profit. Using the ratio of user activity to profit the system can then estimate an increase in odds that will return 10% profit over the next year based on the estimated immediate loss of profit and the estimated increase in user activity due to more enticing odds. If, for example, based on historical data the odds of the next play being a pass are 40%, and the odds adjustment module 20328 determines that a 3% increase would result in a $500 dollar loss, but would be estimated to return $550 dollars due to increased user activity, the odds are then adjusted to 43%. The odds adjustment module 20328 sends, at step 21022, the adjusted odds to the AI comparison Module 20324. The odds adjustment module 20328 ends, at step 21024. It may be appreciated, in some other embodiments, that the odds adjustment module 20328 may function in alternative manners rather than just adjusting odds. For example, if it is deemed desirable, based on estimated wagers or user activity, the odds adjustment module 20328 could send a notification to one or more users who may have been determined, for example based on wagering history, to place a certain bet that would be desirable or provide a desirable return for an upcoming play. Alternatively, the odds adjustment module 20328 could act to lock out or prevent one or more users who may have been determined to place a certain bet that would be undesirable or provide an undesirable return at that time. In still other embodiments, the odds adjustment module 20328 could provide an incentive to one or more users to place a certain bet that is determined to be desirable or provide a desirable return.

FIG. 211 displays the odds adjustment database 20330. The odds adjustment database 20330 contains the original odds from the odds database 20314, for example 40%, the adjusted odds from the odds adjustment module 20328, for example 43%, and a timestamp, for example Nov. 5, 2020 4:46:19 AM.

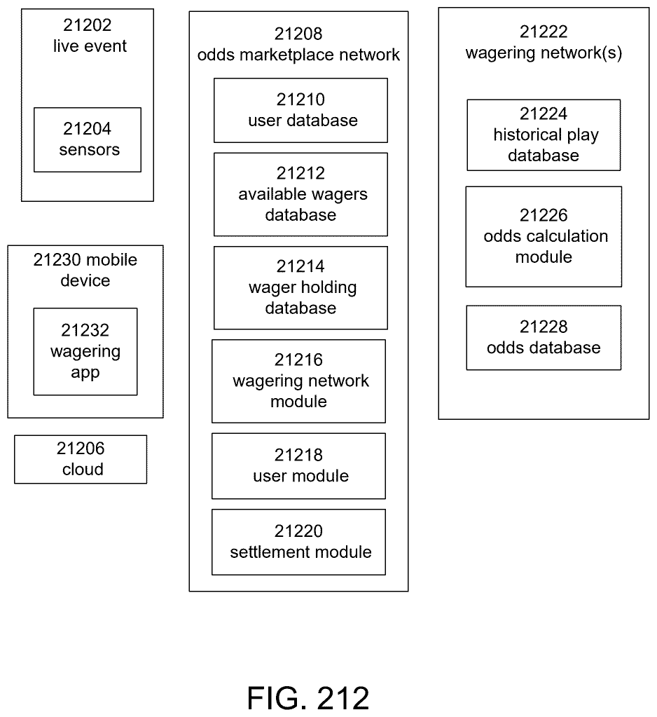

FIG. 212 illustrates a system for in-play wagering through an odds marketplace network, according to an embodiment.

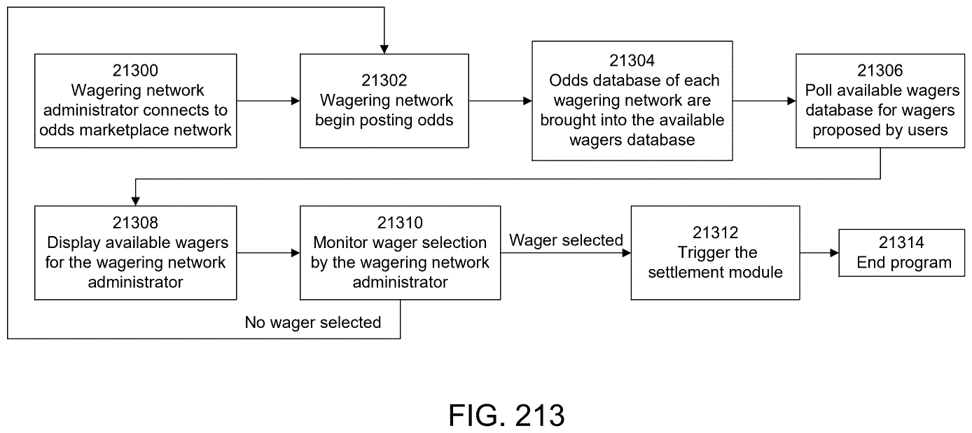

FIG. 213 illustrates a wagering network module, according to an embodiment.

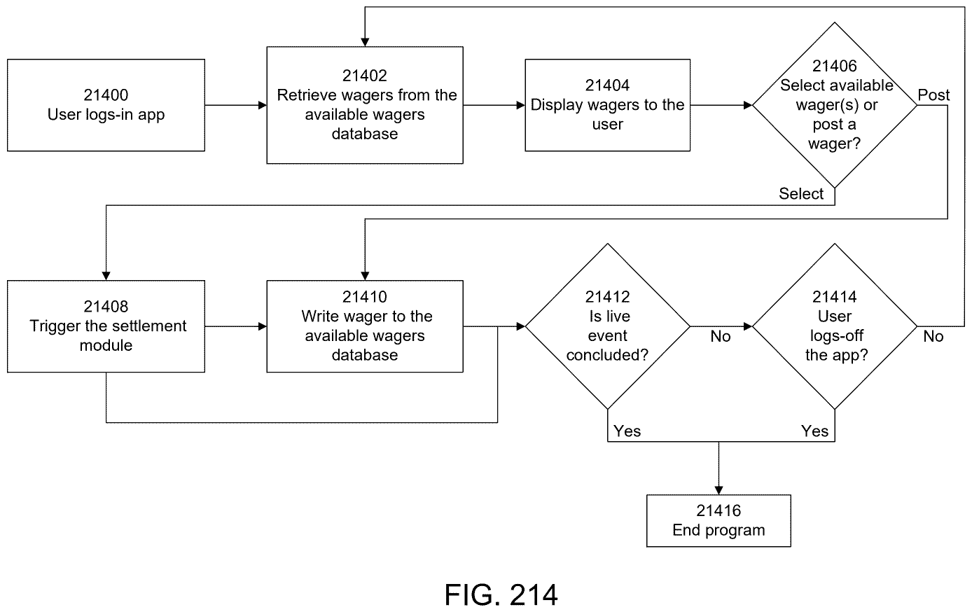

FIG. 214 illustrates a user module, according to an embodiment.

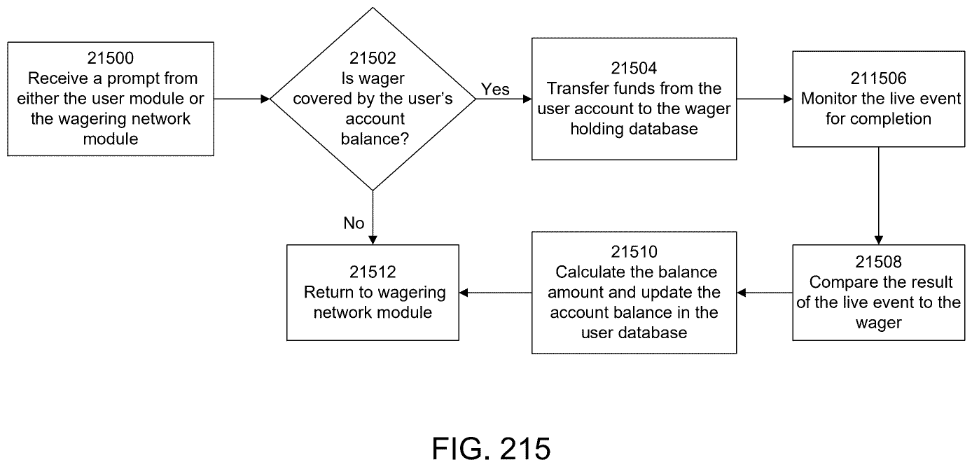

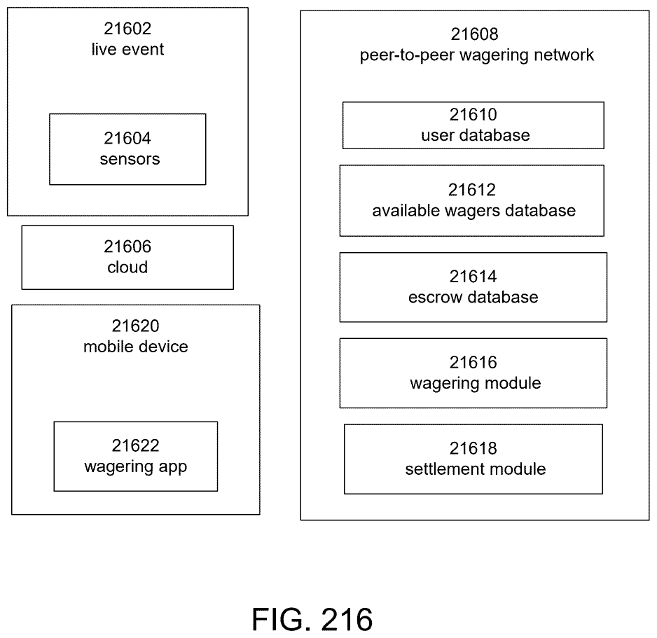

FIG. 215 illustrates a settlement module, according to an embodiment.

FIG. 212 displays a system for in-play wagering through an odds marketplace network 21208. This system comprises of a live event 21202, for example, a sporting event such as a football game, a basketball game, a hockey game, a tennis match, golf tournament, eSports or digital game, etc. The live event 21202 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round-robin, or other styles of tournaments. There are other types of wagers, including parlays, teasers and prop bets, that are added games, that often allow the user to customize their betting, by changing the odds and pay-outs they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 21202, such as the score of American football or the run line in baseball, or a series of action in the live event 21202. Sportsbooks have a number of bets they can handle and a limit of wagers they can take on either side of a bet before they will move the line or odds off of the opening line. Additionally, there are circumstance, such an injury to an important player such as a listed pitcher, in which a sportsbook, casino or racino will take an available wager off the board. As the line moves there becomes an opportunity for a bettor to bet on both sides at different point spreads to middle and win both bets. Sportsbooks will often offer bets on portions of games, such as first half bets and half-time bets. Additionally, the sportsbook can offer futures bets on live events 21202 in the future. Sportsbooks need to offer payment processing services to cash out customers. This can be done at kiosks at the live event 21202 or another location. For example, consider a live event 21202 being a baseball game that is played between the New York Yankees and the Los Angeles Dodgers, at Yankee Stadium, New York City.

Further, embodiments may include a plurality of sensors 21204 that may be used such as motion sensors, temperature sensors, humidity sensors, cameras such as an RGB-D camera which is a digital camera capturing color (RGB) and depth information for every pixel in an image, microphones, a radiofrequency receiver, a thermal imager, a radar device, a LIDAR device, an ultrasound device, a speaker, wearable devices etc. Also, the plurality of sensors 21204 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that collects statistical information through real-time X, Y positioning of players and X, Y, Z positioning of the ball. In the example of a baseball game, the plurality of sensors 21204 may be used for capturing parameters such as spin rate of the ball, ball positions, launch angle, and exit velocity.

Further, embodiments may include a cloud 21206 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable resources and higher-level services that can be rapidly provisioned with minimal management effort, for example over internet, and relies on sharing resources to achieve coherence and economics of scale, like a public utility, while third-party clouds enable organizations to focus on their core businesses instead of expending resources on computer infrastructure and maintenance. The cloud 21206 may be communicatively coupled to each wagering network 21222 which may perform real time analysis on the type of play and the result of the play. The cloud 21206 may also be synchronized with game situational data, such as the time of the game, the score, location on the field, weather conditions, and the like which may affect the choice of play utilized. For example, in other embodiments, the cloud 21206 may not receive data gathered from sensors 21204 and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various embodiments herein.

Further, embodiments may include the odds marketplace network 21208 which may be synchronized with each wagering network 21222 that are performing real-time analysis on the type of play and the result of a play or action. In one embodiment, the odds marketplace network 21208 may facilitate users with a plurality of odds from each wagering network 21222, such as, but not limited to, Draftkings, Wendell, BetMGM, etc. It can be noted that the odds marketplace network 21208 may work as a communication network for each wagering network 21222. Further, the odds marketplace network 21208 may facilitate a user to monitor available wagers and to propose wagers. In another embodiment, the odds marketplace network 21208 may facilitate holding and transferring of funds for the accepted wagers. In one embodiment, the odds marketplace network 21208 may be synchronized with the live event 21202 to track each live event 21202 or the whole season related to the live event 21202. Further, the odds marketplace network 21208 may be synchronized with game situational data, such as the time of the game, the score, location on the field, weather conditions, and the like which may affect the choice of play utilized. In one example embodiment, the odds marketplace network 21208 may facilitate settlement options to the user. In another embodiment, the odds marketplace network 21208 may use third party balance settlement apps. For example, the wagering app 23310 may use Paypal for settlement of the balances of the user.

Further, embodiments may utilize a user database 21210 which contains data relevant to all users of each wagering network 21222, which may include, a user ID, a device identifier, a paired device identifier, wagering history, and wallet information for the user. The user database 21210 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 21210 may contain betting lines and search queries for each wagering network 21222. The user database 21210 may be searched based on a search criteria received from the user. Each betting line may include a plurality of betting attributes such as at least one of the live event 21202, a team, a player, an amount of wager, etc. The user database 21210 may include information related to all the users involved in the live event 21202. In one example embodiment, the user database 21210 may include information for generating a user authenticity report and a wagering verification report. Further, the user database 21210 may be used to store user statistics like, but not limiting to, retention period for a particular user, frequency of wagers placed by a particular user, average amount of wager placed by each user.

Further, embodiments may utilize an available wagers database 21212, that contains wagers available from each wagering network 21222 and wagers proposed by the users. In one embodiment, the wagering networks 21222 may include, but not limited to, Draftkings, Wendell, and BetMGM. For example, the available wagers database 21212 includes that the odds of Aaron Judge hitting a single are 4/1 at Draftkings and 3/1 at Wendell, odds of Aaron Judge hitting a homerun are 3/1 at Draftkings, 2/1 at Wendell, and 3/1 at BetMGM, and odds of Aaron Judge hitting a double are at odds of 2/1 at Draftkings, 2/1 at Wendell, and 3/1 at BetMGM. In one embodiment, the available wagers database 21212 may contain wagers proposed by the users. For example, the available wagers database 21212 includes a wager of $100 on Aaron Judge hitting a single at odds of 4/1, placed by the user. In another example, the available wagers database 21212 includes a wager of $200 on Aaron Judge hitting a double at odds of 3/1, placed by the user.

Further, embodiments may utilize a wager holding database 21214, which holds funds for wagers that are accepted by a wagering network module 21216. For example, with an opening account balance of $2000, the user selects a wager of $100, the wager holding database 21214 holds $100, for further settlement. In one embodiment, the wager holding database 21214 may hold funds with an outside bank network. The wager holding database 21214 may allow the marketplace to hold funds and deliver them to the winner while ensuring wagers can be covered. In one embodiment, the wager holding database 21214 may work as an escrow, which receives and disburses money for the primary transacting parties.

Further, embodiments may include the wagering network module 21216, which is triggered when a wagering network administrator connects to the odds marketplace network 21208. After connecting the wagering network administrator to the wagering network module 21216, the wagering network module 21216 may facilitate each wagering network 21222 to begin posting odds related to the live event 21202. In one embodiment, the wagering networks 21222 may be, but are not limited to, DraftKings, Wendell, or BetMGM. For example, in a baseball game, Aaron Judge of the New York Yankees, is playing in the 3rd inning against Clayton Kershaw of the Los Angeles Dodgers. In a case, a first wagering network 21222 i.e. Draftkings posts odds of Aaron Judge hitting a single are 4/1, hitting a homerun are 3/1, and hitting a double are 2/1. Further, a second wagering network 21222 i.e. Wendell posts odds of Aaron Judge hitting a single are 3/1, hitting a homerun are 2/1, and hitting a double are 2/1. Further, a third wagering network 21222 i.e. BetMGM posts odds of Aaron Judge hitting a homerun are 3/1 and hitting a double are 3/1. Further, the wagering network module 21216 may facilitate an odds database 21228 for each wagering network 21222 brought into the available wagers database 21212. For example, the odds database 21228 of the first wagering network 21222 (Draftkings) includes odds of Aaron Judge hitting a single are 4/1, hitting a homerun are 3/1, and hitting a double are 2/1, odds database 21228 of the second wagering network 21222 (Wendell) includes odds of Aaron Judge hitting a single are 3/1, hitting a homerun are 2/1, and hitting a double are 2/1, and odds database 21228 of the third wagering network (BetMGM) includes the odds of Aaron Judge hitting a homerun are 3/1, and hitting a double are 3/1, are brought into the available wagers database 21212. Further, the wagering network module 21216 may continuously poll the available wagers database 21212 for the wagers proposed by users. In one case, if no wagers from the users are available, then the wagering network module 21216 may return to posting odds related to new wagers available for a next play. In another case, if the wagers are available from the users, then the wagering network module 21216 may display the wagers from the users, to the wagering network administrator. For example, the wagering network module 21216 polls a wager proposed by the user of $100 on Aaron Judge hitting a single at odds of 4/1. Based on the determination that the wagers are available from the users, the wagering network module 21216 may display the available wagers to the wagering network administrator. In an exemplary embodiment, the available wagers may be displayed on a display of a mobile device 21230. For example, the wagering network module 21216 displays a wager of $100 on Aaron Judge hitting a single at odds of 4/1, as proposed by user. Further, the wagering network module 21216 may continuously monitor a wager selection by the wagering network administrator. In one case, if the wagering network administrator selects the available wager, then the wagering network module 21216 may trigger a settlement module 21220. For example, the wagering network administrator selects a wager of $100 on Aaron Judge hitting a single at odds of 4/1 (proposed by user), then the wagering network module 21216 triggers the settlement module 21220. In another case, if the wagering network administrator does not select any available wager, then the wagering network module 21216 may return to posting odds. Based on the determination that the wagering network administrator selects a wager, the wagering network module 21216 may trigger the settlement module 21220. In an alternate embodiment, the wagering network decisions may be made by an automated/algorithmic system, in real-time for in-play wagering. In another embodiment, the wagering network module 21216 may compare the wagers proposed by the user against the odds of different wagering networks 21222. Thereafter, the program ends.

Further, embodiments may include a user module 21218, which is triggered when the user logs-in to the odds marketplace network 21208. The user module 21218 may facilitate the user to access the live event 21202, place wagers or propose wagers related to the live event 21202. Further, the user module 21218 may retrieve wagers from the available wagers database 21212. For example, the user module 21218 retrieves that the odds of Aaron Judge hitting a single are 4/1 at Draftkings and 3/1 at Wendell. In this example, the user module 21218 retrieves that the odds of Aaron Judge hitting a homerun are 3/1 at Draftkings, 2/1 at Wendell, and 3/1 at BetMGM. Further, the user module 21218 retrieves that the odds of Aaron Judge hitting a double are 2/1 at Draftkings, 2/1 at Wendell, and 3/1 at BetMGM. Further, the user module 21218 may display the wagers to the user. In one embodiment, the use module 21218 may display the wagers on a display of the mobile device 21230. For example, the user module 21218 displays odds of Aaron Judge hitting a single are 4/1 at Draftkings and 3/1 at Wendell. In this example, the user module 21218 displays that the odds of Aaron Judge hitting a homerun are 3/1 at Draftkings, 2/1 at Wendell, and 3/1 at BetMGM. Further, the user module 21218 displays that the odds of Aaron Judge hitting a double are 2/1 at Draftkings, 2/1 at Wendell, and 3/1 at BetMGM. After displaying the wagers to the user, the user module 21218 may determine whether the user wants to select the available wager or to post a wager. In one case, when the user selects the available wager, then the user module 21218 may trigger the settlement module 21220. In another case, when the user wants to post a wager, then the user module 21218 goes to the available wagers database 21212. For example, the user wants to post a wager of $100 on Aaron Judge hitting a single at odds of 4/1. Based on the determination that the user selects to select an available wager, the user module 21218 may trigger the settlement module 21220. Based on the determination that the user selects to post a wager, the user module 21218 may move to the available wagers database 21212. Thereafter, the user module 21218 may constantly monitor the live event 21202 for completion. In one case, when the live event 21202 is concluded, then the user module 21218 may again trigger the settlement module 21220, to conclude on the wagers placed by the user. In another case, when the live event 21202 is not concluded, then the user module 21218 may return to retrieving the wagers from the available wagers database 21212. Thereafter, the user module 21218 may also constantly monitor if the user logs-off from a wagering app 21232, during the live event 21202. In one case, when the user logs-off from the wagering app 21232, then the user module 212118 may again trigger the settlement module 21220, to conclude on the wagers placed by the user. In another case, when the user does not log-off from the wagering app 21232, then the user module 21218 may return to retrieving the wagers from the available wagers database 21212. Thereafter, the program ends.

Further, embodiments may include the settlement module 21220 which is triggered when a prompt is received either from the user module 21218 or the wagering network module 21216 after a wager has been accepted. Further, the settlement module 21220 may check if the selected wager is covered by the user's account balance. In one case, if the selected wager is not covered by the user's account balance, then the selected wager may be rendered void. In one embodiment, the user may be notified about low user's account balance. For example, with an opening balance of $2000, the user wants to place a wager of $2100, then the selected wager is rendered void. In another case, if the selected wager is covered by the user's account balance, then the settlement module 21220 may transfer funds (i.e. wager) from the user account to the wager holding database 21214. For example, with an opening balance of $2000, the user selects a wager of $100 on Aaron Judge of the New York Yankees, playing in the 3rd inning against Clayton Kershaw of the LA dodgers, hitting a single at odds of 4/1, then the settlement module 21220 transfers $100 to the wager holding database 21214. It can be noted the funds transferred from the user's account balance may be temporary. In one embodiment, the funds transferred may be returned in case of cancellation of wager before a threshold time. For example, a user may cancel a wager within 30 seconds of placing the wager to return amount related to the placed wager. Further, the settlement module 21220 may constantly monitor the live event 21202 for completion. In one case, when the live event 21202 is concluded, then the settlement module 21220 may proceed to obtain the results of the live event 21202. For example, the result of the live event 21202 is that Aaron Judge hits a single during the live event 21202. In another case, when the live event 21202 is not concluded, then the settlement module 21220 may continue monitoring the live event 21202 for completion. Further, the settlement module 21220 may compare the result of the live event 21202 with the wagers placed by the user, to determine a result i.e. whether the user has won or lost. In this example, the wager of $100 placed for Aaron Judge of the New York Yankees, playing in the 3rd inning against Clayton Kershaw of the LA dodgers, hitting a single and the result of the live event 21202 i.e. Aaron Judge of the New York Yankees, playing in the 3rd inning against Clayton Kershaw of the LA dodgers, hits a single, are compared to determine the result of the wager i.e. a win for the user. Based on the comparison of the result of the live event 21202 and the wagers placed by the user, the settlement module 21220 may calculate the balance amount for the user. For example, the user wins the wager of $100 at +400 odds that Aaron Judge will hit a single on the next play and the result of the live event 21202 is Aaron Judge hits a single. Thus, the updated balance of the user (with an opening balance of $2000), after the completion of the live event 21202, will be $2000+$400=$2400. Further, the settlement module 21220 may update the account balance of the user who places the wager in the user database 21210. In this example, after winning the wager of $100 placed (at odds of 4/1), the updated balance of the user is $2400. Thereafter, the process returns to the wagering network module 21216. Further, embodiments may include the wagering networks 21222 which may perform real-time analysis on the type of play and the result of a play or action. Each wagering network 21222 (or cloud 21206) may also be synchronized with game situational data, such as the time of the game, the score, location on the field, weather conditions, and the like which may affect the choice of play utilized. For example, in other embodiments, the wagering networks 21222 may not receive data gathered from sensors 21204 and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various embodiments herein. Each wagering network 21222 can offer a number of software as a service managed services such as, user interface service, risk management service, compliance, pricing and trading service, IT support of the technology platform, business applications, game configuration, state-based integration, integration to allow the joining of social media, as well as marketing support services that can create engaging promotions to the user. In one embodiment, each wagering network 21222, via the wagering app 21232, may facilitate settlement options to the user. In one example embodiment, the wagering networks 21222 may refer to a first wagering network, a second wagering network, and a third wagering network. In one embodiment, the various wagering networks 21222 may be, but are not limited to, DraftKings, Wendell, BetMGM, etc. In one embodiment, each wagering network 21222 may facilitate users to place bets on during the live event 21202. In another embodiment, the wagering networks 21222 may use third party balance settlement apps. For example, the wagering app 21232 may use Paypal for settlement of the balances of the user.

Further, embodiments may include a historical play database 21224 that contains play data for the type of sport being played in the live event 21202. The historical play database 212124 may be associated with each respective wagering network 21222. In one embodiment, for optimal odds calculation, the historical play data should include metadata about the historical plays, such as time of the live event 21202, location, weather, previous plays, opponent, physiological data of the players (including blood pressure, pulse rate, and respiration rate), the batting average of all players, information related to the players such as injuries in the past, batting average, earned run average, catch probability, spin rate, launch angle, exit velocity, a bunt, a single, a double, a triple, a home run, a caught, a fly ball, information related to trainers of each player, etc. For example, in the baseball game, information stored in the historical play database 21224 may include information related to the previous baseball games played by the New York Yankees such as, but not limited to, the weather condition, i.e. during the match, it was cloudy.

Further, embodiments may include an odds calculation module 21226 which utilizes information from the historical plays database 21224 and the information from the sensor feeds of sensors 21204 to calculate odds for in-play wagers. The odds calculation module 21226 may be associated with each respective wagering network 21222. The information from the historical plays database 21224 may include data related to the type of the play, the previous information related to players involved in the live event 21202, and results of the previous live events 21202. The odds for each live event 21202, such as in a baseball game a particular player hitting a home run, a single, or a strikeout, may be calculated based on the information received from the sensor feeds of sensors 21204 and the previous information related to the particular player. Further, the odds may be updated based on in-game events (for example, a player strikes a home run with the same pitcher, decreasing his odds of getting a strikeout from the same pitcher). The odds may be calculated or adjusted based on statistical information related to the live event 21202 and the statistical information of the players. For example, the odds may be determined based on the historical data such as prior performance information about a player (like batting average against a certain pitcher, earned run average, catch probability, hamstring strain), and physiological information of player(s) etc., and current i.e. real-time information, such as current confidence level etc. In one embodiment, the type of wagering may depend on the type of game being played. In one embodiment, the odds calculation module 21226 may determine the available wagers to the user. The odds calculation module 21226 may also utilize a probability engine, which assembles all the historical data and real-time data and produces the odds (stored in the odds database 21228) for in-play wagers. Thus, the odds calculation module 21226 stores information relevant to all the potential outcomes as available wagers, which facilitates the user with better knowledge to make certain judgements about the potential performance of players in each live event 21202 and place a calculated wager with a potential return on the wager. For example, in a baseball game, the odds calculation module 21226 may calculate that the odds related to the possible outcomes of an at-bat for Aaron Judge of the New York Yankees hitting against Clayton Kershaw of the LA Dodgers are, hitting a single at 4/1, hitting a double at 3/1, hitting a home run at 2/1, and getting a strikeout at 2/1. Further, embodiments may include the odds database 21228 which contains the odds calculated by the odds calculation module 21226. The odds database 21228 may be associated with each respective wagering network 21222. The odds may represent the potential outcomes on the next play. For example, the odds database 21228 may include odds to the overall match such as odds of winning a match, odds related to the pitcher, odds related to the hitter (scoring a single/double/home run). Further, the odds database 21228 may store all the odds to be displayed via the wagering app 21232. In one embodiment, the type of wagering may depend on the type of game being played.

Further, embodiments may include a mobile device 21230 such as a computing device, laptop, smartphone, tablet, computer, smart speaker, or I/O devices. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. devices allow for voice recognition and inputs, including, e.g., Microsoft KINECT, SIRI for IPHONE by Apple, Google Now or Google Voice Search. Additional mobile devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also allow storage and/or an installation medium for the computing device. In still other embodiments, the computing device may allow USB connections (not shown) to receive handheld USB storage devices. In further embodiments, a I/O device may be a bridge between a system bus and an external communication bus, e.g. a USB bus, a SCSI bus, a FireWire bus, an Ethernet bus, a Gigabit Ethernet bus, a Fiber Channel bus, or a Thunderbolt bus. Further, the mobile device 21230 could be an optional component and would be utilized in a situation in which the paired wearable device is utilizing the mobile device 21230 as additional memory or computing power or connection to the internet.

Further, embodiments may include the wagering app 21232 which allows the user to place in-play wagers during the live event 21202. In one embodiment, the wagering app 21232 may be a mobile application or web application, which runs on the mobile device 21230. The wagering app 21232 may allow the user to receive data related to the live event 21202. For example, in the baseball game, Aaron Judge of the New York Yankees is playing in the 3rd inning against Clayton Kershaw of the LA dodgers. In one embodiment, the wagering app 21232 may present the user with the wagers available, related to a particular live event 21202. Further, the wagering app 21232 may allow the user to place in-play wagers corresponding to the available wagers. In one embodiment, the wagering app 21232 may facilitate the user with an interface i.e. a graphical user interface (GUI) for performing various operations such as, but not limited to, proposing new wagers, linking other applications with the wagering app 21232, storing user's personal details, etc. In one embodiment, the wagering app 21232 may store information related to the placed wagers. In another embodiment, the wagering app 21232 may facilitate the user to enable setting reminders related to a particular live event 21202. Further, when the live event 21202 concludes, the wagering app 21232 may facilitate settlement of balances for the user. In another embodiment, the wagering app 21232 may trigger third party balance settlement apps linked to the wagering app 21232 for settlement of the balances of the user. For example, the wagering app 21232 may use Paypal for settlement of the balances of the user.

FIG. 213 displays the wagering network module 21216. The wagering network module 21216 is triggered when a wagering network administrator connects, at step 21300, to the odds marketplace network 21208. After connecting the wagering network administrator to the wagering network module 21216, the wagering network module 21216 may facilitate each wagering network 21222 to begin, at step 21302, posting odds related to the live event 21202. In one embodiment, the wagering networks 21222 may be, but are not limited to, DraftKings, Wendell, or BetMGM. For example, in a baseball game, Aaron Judge of the New York Yankees, playing in the 3rd inning against Clayton Kershaw of the Los Angeles Dodgers. In a case, a first wagering network 21222 i.e. Draftkings posts that the odds of Aaron Judge hitting a single are 4/1, hitting a homerun are 3/1, and hitting a double are 2/1. Further, a second wagering network 21222 i.e. Wendell posts that the odds of Aaron Judge hitting a single are 3/1, hitting a homerun are 2/1, and hitting a double are 2/1. Further, a third wagering network 21222 i.e. BetMGM posts that the odds of Aaron Judge hitting a homerun are 3/1 and hitting a double are 3/1. Further, the wagering network module 21216 may facilitate, at step 21304, the odds database 21228 of each wagering network 21222 brought into the available wagers database 21212. For example, the odds database 21228 of the first wagering network 21222 (Draftkings) may include that the odds of Aaron Judge hitting a single are 4/1, hitting a homerun are 3/1, and hitting a double are 2/1, the odds database 21228 of the second wagering network 21222 (Wendell) may include that the odds of Aaron Judge hitting a single are 3/1, hitting a homerun are 2/1, and hitting a double are 2/1, and the odds database 21228 of the third wagering network 21222 (BetMGM) may include that the odds of Aaron Judge hitting a homerun are 3/1, and hitting a double are 3/1, all of which are brought into the available wagers database 21212. Further, the wagering network module 21216 may continuously poll, at step 21306, the available wagers database 21212 for the wagers proposed by users. In one case, if no wagers from the users are available, then the wagering network module 21216 may return to step 21302, and post odds related to new wagers available for a next play. In another case, if the wagers are available from the users, then the wagering network module 21216 may display the wagers from the users, to the wagering network administrator. For example, the wagering network module 21216 polls a wager proposed by the user of $100 on Aaron Judge hitting a single at odds of 4/1. Based on the determination that the wagers are available from the users, the wagering network module 21216 may display, at step 21308, the available wagers to the wagering network administrator. In an exemplary embodiment, the available wagers may be displayed on a display of the mobile device 21230. For example, the wagering network module 21216 displays a wager of $100 on Aaron Judge hitting a single at odds of 4/1, as proposed by a user. Further, the wagering network module 21216 may continuously monitor, at step 21310, a wager selection by the wagering network administrator. In one case, if the wagering network administrator selects the available wager, then the wagering network module 21216 may trigger the settlement module 21220. For example, when the wagering network administrator selects a wager of $100 on Aaron Judge hitting a single at odds of 4/1 (proposed by a user), then the wagering network module 21216 triggers the settlement module 21220. In another case, if the wagering network administrator does not select any available wager, then the wagering network module 21216 may return to step 201302, and resume posting odds. Based on the determination that the wagering network administrator selects a wager, the wagering network module 21216 may trigger, at step 21312, the settlement module 21220. Thereafter, the program ends, at step 21314.

FIG. 214 displays the user module 21218. The user module 21218 is triggered when the user logs-in, at step 21400, to the odds marketplace network 21208. The user module 21218 may facilitate the user to access the live event 21202, place wagers or propose wagers related to the live event 21202. Further, the user module 21218 may retrieve, at step 21402, wagers from the available wagers database 21212. For example, the user module 21218 retrieves that the odds of Aaron Judge hitting a single are 4/1 at Draftkings and 3/1 at Wendell. In this example, the user module 21218 retrieves that the odds of Aaron Judge hitting a homerun are 3/1 at Draftkings, 2/1 at Wendell, and 3/1 at BetMGM. Further, the user module 21218 retrieves that the odds of Aaron Judge hitting a double are 2/1 at Draftkings, 2/1 at Wendell, and 3/1 at BetMGM. Further, the user module 21218 may display, at step 21404, the wagers to the user. In one embodiment, the use module 21218 may display the wagers on the mobile device 21230. For example, the user module 21218 displays that the odds of Aaron Judge hitting a single are 4/1 at Draftkings and 3/1 at Wendell. In this example, the user module 21218 displays that the odds of Aaron Judge hitting a homerun are 3/1 at Draftkings, 2/1 at Wendell, and 3/1 at BetMGM. Further, the user module 21218 displays that the odds of Aaron Judge hitting a double are 2/1 at Draftkings, 2/1 at Wendell, and 3/1 at BetMGM. After displaying the wagers to the user, the user module 21218 may determine, at step 21406, whether the user wants to select the available wager or to post a wager. In one case, when the user selects the available wager, then the user module 21218 may trigger the settlement module 21220. In another case, when the user wants to post a wager, then the user module 21218 goes to the available wagers database 21212. For example, the user wants to post a wager of $100 on Aaron Judge hitting a single at odds of 4/1. Based on the determination that the user selects to select an available wager, the user module 21218 may trigger, at step 21408, the settlement module 21220. Based on the determination that the user selects to post a wager, the user module 21218 may write, at step 21410, the user's posted wager in the available wagers database 21212. Thereafter, the user module 21218 may constantly monitor, at step 21412, the live event 21202 for completion. In one case, when the live event 21202 is concluded, then the user module 21218 may again trigger the settlement module 21220, to conclude on the wagers placed by the user. In another case, when the live event 21202 is not concluded, then the user module 21218 may return to step 21402, in order to retrieve the wagers from the available wagers database 21212. Thereafter, the user module 21218 may also constantly monitor, at step 21414, if the user logs-off from the wagering app 21232, during the live event 21202. In one case, when the user logs-off from the wagering app 21232, then the user module 21218 may again trigger the settlement module 21220, to conclude on the wagers placed by the user. In another case, when the user does not logs-off from the wagering app 21232, then the user module 21218 may return to step 21402, in order to retrieve the wagers from the available wagers database 21212. Thereafter, the program ends at step 21416.

FIG. 215 displays the settlement module 21220. The settlement module 21220 may receive, at step 21500, a prompt from either the user module 21218 or the wagering network module 21216 after a wager has been accepted. Further, the settlement module 21220 may check, at step 21502, if the selected wager is covered by the user's account balance. In one case, if the selected wager is not covered by the user's account balance, then the selected wager may be rendered void. In one embodiment, the user may be notified about low user's account balance. For example, with an opening balance of $2000, the user wants to place a wager of $2100, then the selected wager is rendered void. In another case, if the selected wager is covered by the user's account balance, then the settlement module 21220 may transfer funds (i.e. wager) from the user account to the wager holding database 21214. Based on the determination that the wager is covered by the user's account balance, the settlement module 21220 may transfer, at step 21504, funds (i.e. wager) from the user account to the wager holding database 21214. For example, with an opening account balance of $2000, the user selects a wager of $100 on Aaron Judge hitting a single at odds of 4/1, the settlement module 21220 transfers $100 from the user's account balance to the wager holding database 21214. Further, the settlement module 21220 may constantly monitor, at step 21506, the live event 21202 for completion. In one case, when the live event 21202 is concluded then the settlement module 21220 may proceed to obtain the results of the live event 21202. For example, the result of the live event 21202 is that Aaron Judge hits a single during the live event 21202. In another case, when the live event 21202 is not concluded, then the settlement module 21220 may continue monitoring the live event 21202 for completion. Further, the settlement module 21220 may compare, at step 21508, the result of the live event 21202 with the wagers placed by the user, to determine a result i.e. whether the user has won or lost. In this example, the wager of $100 placed for Aaron Judge hitting a single and the result of the live event 21202 i.e. Aaron Judge hits a single, are compared to determine the result of the wager i.e. a win for the user. Based on the comparison of the result of the live event 21202 and the wagers placed by the user, the settlement module 21220 may calculate, at step 21510, the balance amount for the user. For example, the user wins the wager of $100 at +400 odds that Aaron Judge will hit a single on the next play and the result of the live event 21202 is Aaron Judge hits a single. Thus, the updated balance of the user (with an opening balance of $2000) after the completion of the live event 21202 will be $2000+$400=$2400. Further, the settlement module 21220 may update, at step 21512, the account balance of the user who places the wager in the user database 21210. In this example, after winning the wager of $100 placed (at odds of 4/1), the updated balance of the user i.e. $2400. Thereafter, the process returns, at step 21512, to the wagering network module 21216.

FIG. 216 illustrates a system for a player focused wagering system, according to an embodiment.

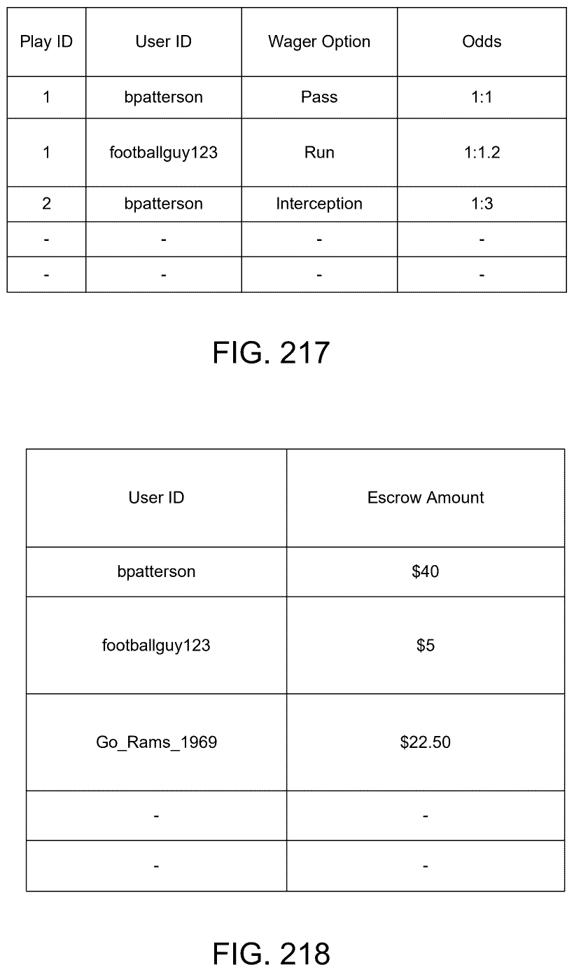

FIG. 217 illustrates an available wagers database, according to an embodiment.

FIG. 218 illustrates an escrow database, according to an embodiment.

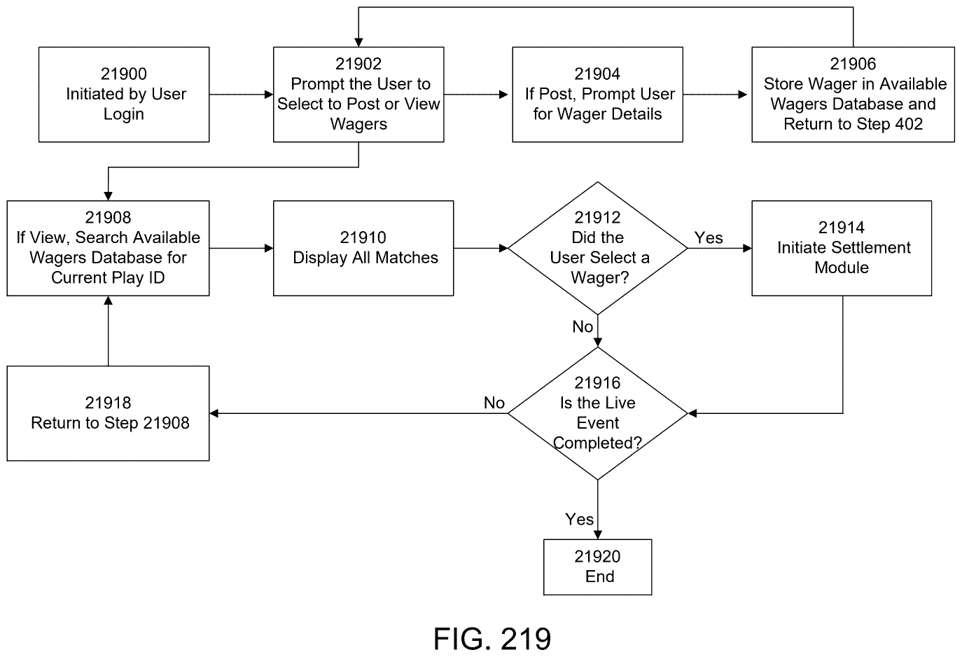

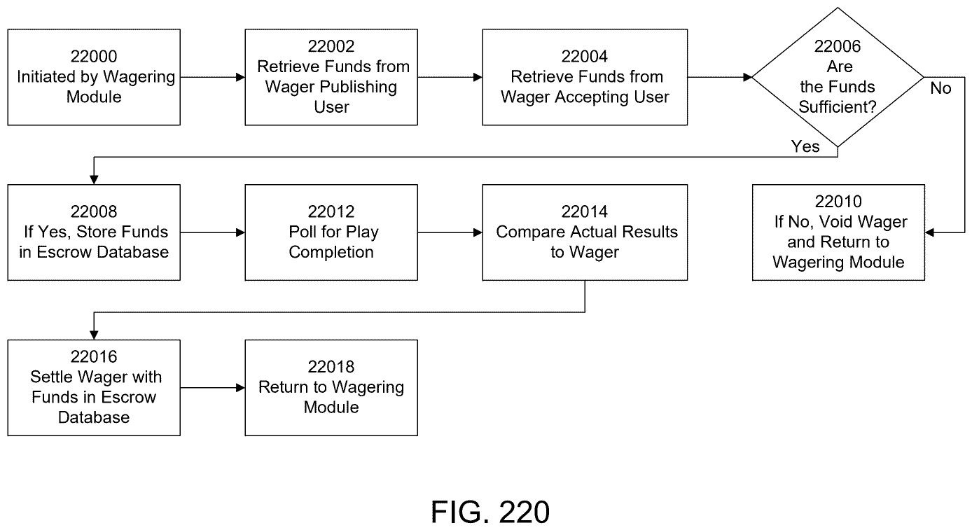

FIG. 219 illustrates a wagering module, according to an embodiment.

FIG. 220 illustrates a settlement module, according to an embodiment.

FIG. 216 displays a system for a player focused wagering system. This system may include a live event 21602, for example a sporting event such as a football game, basketball game, baseball game, hockey game, tennis match, golf tournament, eSports or digital game, etc. The live event 21602 will include some number of actions or plays, upon which a user, bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as a chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 21602, such as the score of American football or the run line in baseball, or a series of action in the live event 21602. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live event 21602 in the future. Sportsbooks need to offer payment processing services in order to cash out customers. This can be done at kiosks at the live event 21602 or at another location.

Further, embodiments may include a plurality of sensors 21604 that may be used such as motion sensors, temperature sensors, humidity sensors, cameras such as an RGB-D camera which is a digital camera capable of capturing color (RGB) and depth information for every pixel in an image, microphones, a radiofrequency receiver, a thermal imager, a radar device, a lidar device, an ultrasound device, a speaker, wearable devices etc. Also, the plurality of sensors 21604 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 21606 or communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, for example over the Internet, and relies on sharing of resources to achieve coherence and economics of scale, like a public utility, while third-party clouds 21606 allow organizations to focus on their core businesses instead of expending resources on computer infrastructure and maintenance. The cloud 21606 may be communicatively coupled to a peer-to-peer wagering network 21608 which may perform real time analysis on the type of play and the result of the play. The cloud 21606 may also be synchronized with game situational data, such as the time of the game, the score, location on the field, weather conditions, and the like which may affect the choice of play utilized. For example, in some exemplary embodiments, the cloud 21606 may not receive data gathered from sensors 21604 and may, instead, receive data from an alternative data feed, such as Sports Radar®. This data may be compiled substantially immediately following the completion of any play and the data from this feed may be compared with a variety of team data and league data based on a variety of elements, including down, possession, score, time, team, and so forth, as described in various exemplary embodiments herein.

Further, embodiments may include the peer-to-peer wagering network 21608 which may perform real time analysis on the type of play and the result of a play or action. The peer-to-peer wagering network 21608 (or cloud 21606) may also be synchronized with game situational data, such as the time of the game, the score, location on the field, weather conditions, and the like which may affect the choice of play utilized. For example, in other exemplary embodiments, peer-to-peer wagering network 21608 may not receive data gathered from sensors 21604 and may, instead, receive data from an alternative data feed, such as Sports Radar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 21608 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may include a user database 21610 which contains data relevant to all users of the system, which may include, a user ID of the user, a device identifier for a mobile device 21620, a list of the players indicated as favorites by the user, and could also include wagering history on the user, and other relevant user data.

Further, embodiments may include an available wager database 21612 which stores wagers available for users to select and which are published by other users.

Further, embodiments may include an escrow database 21614 which stores transactions being facilitated by the wagering network 21608 and will hold the funds until the wager is settled. The escrow database 21614 may also store settlement terms for transactions being facilitated either directly between the two users or through a third-party platform.

Further, embodiments may include a wagering module 21616 that allows users to propose and accept wager odds and terms, for example, a user may propose 2 to 1 odds that the next play of a football game is a run, then another user or other users may accept the proposing user's odds and terms.

Further, embodiments may include a settlement module 21618 which determines if both the proposing user and wagering user have accepted terms, which may include transferring money or credit into the escrow database, then settles the wager based on the actual results of the subject of the wager, for example, the next play of the game.

Further, embodiments may include the mobile device 21620 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices provides for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 21620 could be an optional component and would be utilized in a situation in which a paired wearable device is utilizing the mobile device 21620 as additional memory or computing power or connection to the internet.

Further, embodiments may include a wagering app 21622, which is a program that enables the user to place bets on individual plays in the live event 21602, and display the audio and video from the live event 21602, along with the available wagers on the mobile device 21620. The wagering app 21622 allows the user to interact with the peer-to-peer wagering network 21608 in order to place bets and provide payment/receive funds based on wager outcomes.

FIG. 217 displays the available wagers database 21612. The available wager database 21612 stores wagers available for users to select which are published by other users. The database contains a play ID corresponding to a play of the live game 21602, for example 1, a user ID of the user that created the wager, for example, “bpatterson”, the wager option the user would be betting on, for example “pass”, and the odds, for example 1:1, in some embodiments the database may also contain terms of the wager, for example, the number of users who can take the wager, the maximum or minimum wager amount, if the publishing user can revoke the wager, etc.

FIG. 218 displays the escrow database 21614. The escrow database 21614 stores transactions being facilitated by the wagering network 21608 and will hold the funds until the wager is settled. The escrow database 21614 may also store settlement terms for transactions being facilitated either directly between users or through a third-party platform. The escrow database 21614 contains at least a user ID, for example, “bpatterson” and an amount in escrow, for example $40.

FIG. 219 displays the wagering module 21616. The process begins with the wagering module 21616 being, at step 21900, initiated by user login via the wagering app 21622, login includes at least a user ID, for example user Bob Patterson is watching a baseball game and logs into the wagering app 21622 to make wagers with his user ID “bpatterson”, in some embodiments login may include security credentials such as a password. The wagering module 21616 prompts, at step 21902, the user to select either to post or view a wager for the next play of the live game 21602, in some embodiments this choice may be facilitated by interactable on a GUI, for example, user Bob Patterson may see two buttons on his mobile device 21620 that say “Post a Wager” and “View Wagers”. If the user selects to post a wager, the wagering module 21616 prompts, at step 21904, the user for details of the wager, which include the outcome being wagered on, for example “pass” or “run”, and the odds the user is willing to offer other users, for example 1:1, in some embodiments there may also be additional term settings the user may provide, for example, the number of users who can take the wager, the maximum or minimum wager amount, if the publishing user can revoke the wager, etc. The wagering module 21616 stores, at step 21906, the wager and details of the wager in the available wagers database 21612 with a play ID corresponding to the upcoming play. Then the wagering module 21616 returns to step 21902. If the user selects to view wagers, the wagering module 21616 searches, at step 21908, the available wagers database 21612 for all entries that match the play ID of the upcoming play of the live game 21602. The wagering module 21616 displays, at step 21910, all matching entries in the available wagers database 21612. The wagering module 21616 determines, at step 21912, if the user has selected a wager, for example, user Bob Patterson is sure the next play is going to be a run, looking at all the available wagers, he selects one that has “run” as an option and has the best payout for him based on the odds. If the user has selected a wager, the wagering module 21616 initiates, at step 21914, the settlement module 21618, and sends in the selected wager data. The wagering module 21616 determines, at step 21916, if the live event 21602 has been completed. If the live event 21602 is not completed, The wagering module 21616 returns, at step 21918, to step 21908, which will update the displayed matches if any new wagers have been added to the available wagers database 21612, in some embodiments there may be a wait period before the wagering module 21616 returns to step 21908 to reduce the load on the system. If the live event 21602 is complete, The wagering module 21616 ends, at step 21920.

FIG. 220 displays the settlement module 21618. The process begins with the settlement module 21618 being, at step 22000, initiated by the wagering module 21616 and receiving details about the selected wager from the wagering module 21616. The settlement module 21618 retrieves, at step 22002, funds from the user who created and posted the wager, by prompting the user for payment information, for example, credit card information, and collecting the required amount of funds, in some embodiments the funds may be retrieved from a database which stores user payment information or a pre-paid amount of credit or points, in some embodiments the user who created and posted the wager may have to put forward some amount of funds before the wager can be posted. The settlement module 21618 retrieves, at step 22004, funds from the user who accepted the wager, by prompting the user for payment information, for example, credit card information, and collecting the required amount of funds, in some embodiments the funds may be retrieved from a database which stores user payment information or a pre-paid amount of credit or points, in some embodiments the user will also be prompted for the amount they intend to wager at this step. The settlement module 21618 determines, at step 22006, if the funds retrieved from both the publishing user and accepting user are sufficient, in some embodiments this may include checking with a third party, for example, the user's credit card company. If both users have sufficient funds, the settlement module 21618 stores, at step 22008, those funds in the escrow database 21614, in some embodiments this step may include making a charge to the users via their method of payment, for example, user Bob Patterson is paying via credit card, at this step his card would be charged and the funds would be stored in escrow until the wager is resolved. If one or both users do not have sufficient funds, the settlement module 21618 voids, at step 22010, the wager and returns to the wagering module 21616. The settlement module 21618 polls, at step 22012, for completion of the current play of the live event 21602. The settlement module 21618 compares, at step 22014, the actual results of the play of the live event 21602 to the user's wager selection. The settlement module 21618 uses, at step 22016, the funds stored in the escrow database 21614 from each user involved in the wager to pay the winning user, in some embodiments this may involve transferring the funds into another database, for example, the user database 21610, in another embodiment the users may settle the wager directly and the settlement module 21618 will notify at least one user with the results of the wager, in another embodiment the transaction may be handled by a third party in which case the settlement module 21618 sends a notification to the third party and may also notify the users. The settlement module 21618 returns, at step 22018, to the wagering module 21616.

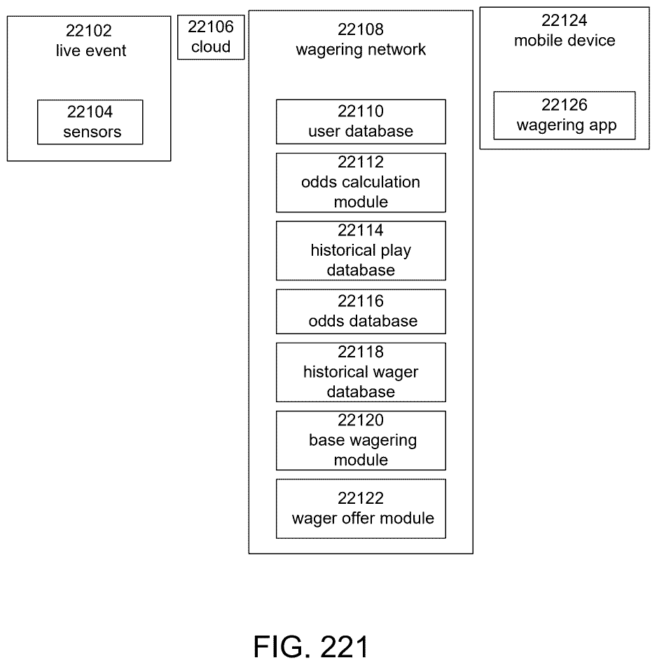

FIG. 221 illustrates a system for a player focused wagering system, according to an embodiment.

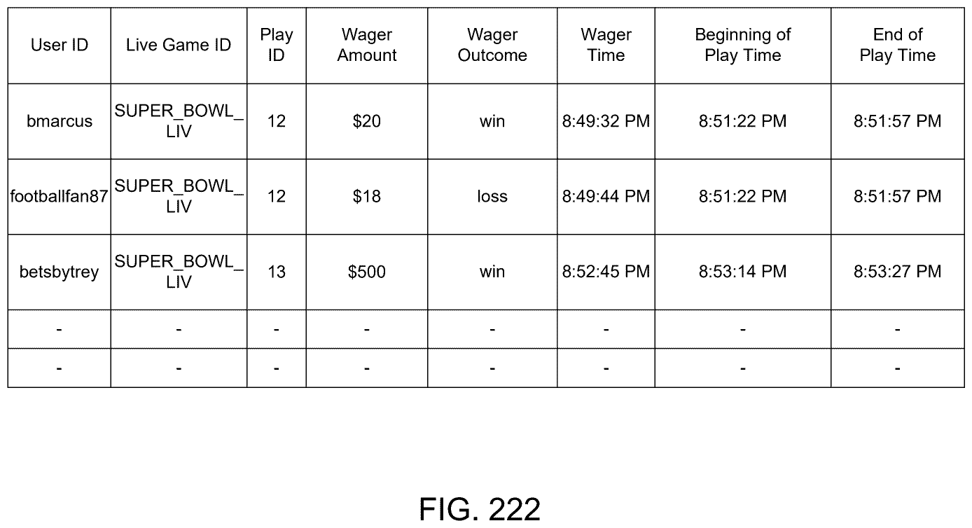

FIG. 222 illustrates a historical wager database, according to an embodiment.

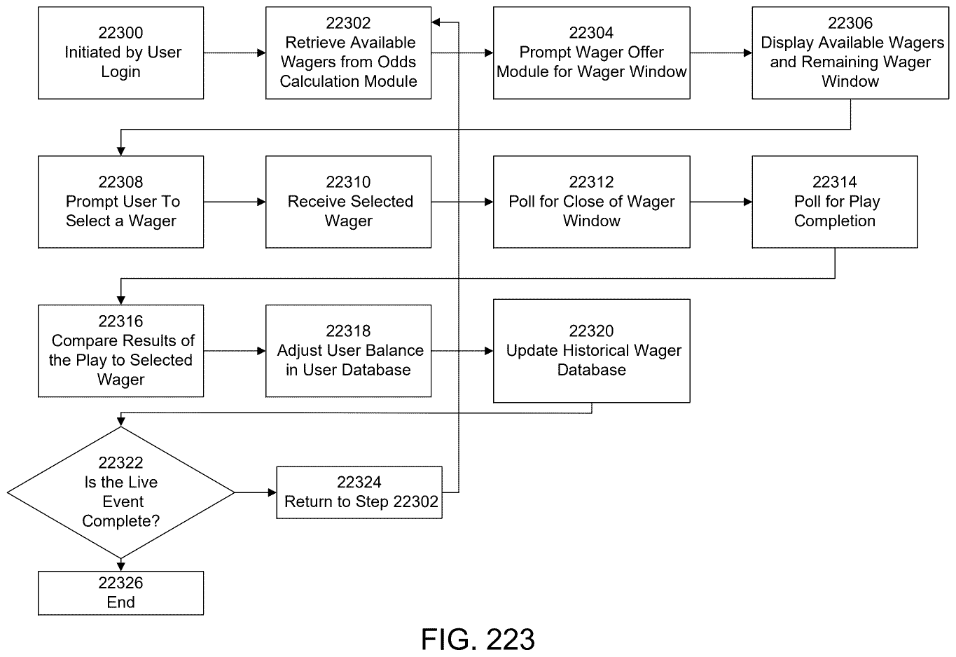

FIG. 223 illustrates a base wagering module, according to an embodiment.

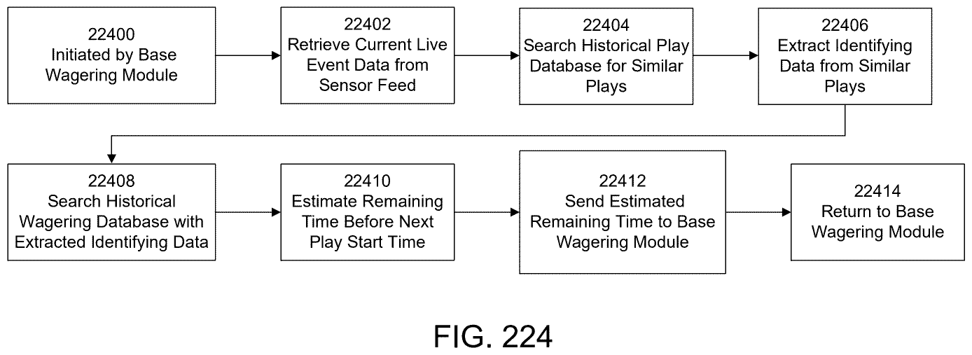

FIG. 224 illustrates a wager offer module, according to an embodiment.

FIG. 221 is a system for a player focused wagering system. This system may include a live event 22102, for example a sporting event such as a football game, basketball game, baseball game, hockey game, tennis match, golf tournament, eSports or digital game, etc. The live event 22102 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 22102, such as the score of American football or the run line in baseball, or a series of action in the live event 22102. Sportsbooks have a number of bets they can handle, a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live event 22102 in the future. Sportsbooks need to offer payment processing services in order to cash out customers. This can be done at kiosks at the live event 22102 or at another location.

Further, embodiments may include a plurality of sensors 22104 that may be used such as motion sensors, temperature sensors, humidity sensors, cameras such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices etc. Also, the plurality of sensors 22104 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 22106 or communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the Internet and relies on sharing of resources to achieve coherence and economics of scale, like a public utility, while third-party clouds allow organizations to focus on their core businesses instead of expending resources on computer infrastructure and maintenance. The cloud 22106 may be communicatively coupled to wagering network 22108 which may perform real time analysis on the type of play and the result of the play. The cloud 22106 may also be synchronized with game situational data, such as the time of the game, the score, location on the field, weather conditions, and the like which may affect the choice of play utilized. For example, in other exemplary embodiments, the cloud 22106 may not receive data gathered from sensors 22104 and may, instead, receive data from an alternative data feed, such as Sports Radar®. This data may be compiled substantially immediately following the completion of any play and the data from this feed may be compared with a variety of team data and league data based on a variety of elements, including down, possession, score, time, team, and so forth, as described in various exemplary embodiments herein.

Further, embodiments may include a wagering network 22108 which may perform real time analysis on the type of play and the result of a play or action. The wagering network 22108 (or cloud 22106) may also be synchronized with game situational data, such as the time of the game, the score, location on the field, weather conditions, and the like which may affect the choice of play utilized. For example, in other exemplary embodiments, the wagering network 22108 may not receive data gathered from sensors 22104 and may, instead, receive data from an alternative data feed, such as Sports Radar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 22108 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may include a user database 22110 which contains data relevant to all users of the system, which may include, a user ID of the user, a device identifier for their mobile device 22124, a list of the players indicated as favorites by the user, and could also include wagering history on the user, and other relevant user data.

Further, embodiments may include an odds calculation module 22112 which utilizes historical play data to calculate odds for in-play wagers.

Further, embodiments may include a historical plays database 22114, that contains play data for the type of sport being played in live event 22102. For example, in American football for optimal odds calculation, the historical play data should include meta data about the historical plays, such as time, location, weather, previous plays, opponent, physiological data, etc.

Further, embodiments may include an odds database 22116 that contains the odds calculated by the odds calculation module 22112 to display the odds the user's mobile device 22124 and to take bets from the user through the mobile device 22124 wagering app 22126.

Further, embodiments may include a historical wager database 22118 which stores data on wagers from both current and previous live events 22102.

Further, embodiments may include a base wagering module 22120 which allows a user to log in and place wagers on upcoming plays of the live event 22102 during a estimated time window. The base wagering module 22120 then compares the actual results of the play to the wager in order to determine if the user won or lost their wager and then changes the user's account balance. In some embodiments a third party may control the user's balance and the base wagering module 22120 send data to the third party or notify the third party if the user won or lost their wager.

Further, embodiments may include a wager offer module 22122 which estimates the amount of time before the next play based on data in the historical wager database 22118 and sends that estimate to the base wagering module 22120.

Further, embodiments may include a mobile device 22124 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allows for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 22124 could be an optional component and would be utilized in a situation in which a paired wearable device is utilizing the mobile device 22124 as additional memory or computing power or connection to the internet.

Further, embodiments may include a wagering app 22126, which is a program that enables the user to place bets on individual plays in the live event 22102, and display the audio and video from the live event 22102, along with the available wagers on the mobile device 22124. The wagering app 22126 allows the user to interact with the wagering network 22108 in order to place bets and provide payment/receive funds based on wager outcomes.

FIG. 222 illustrates the historical wager database 22118. The historical wager database 22118 contains data on wagers made by users in the past via the wagering app 22126. This data includes a user ID, for example, “bmarcus”, a live game ID, for example, “SUPER_BOWL_LIV”, a play ID, for example, “12”, the amount wagered, for example, “$20”, the outcome of the wager, for example, “win”, the time of the wager, for example, “8:49:32 PM”, the time of the beginning of the play, for example, “8:51:22 PM”, and the time of the end of the play, for example, “8:51:57 PM” in some embodiments additional data may be contained in the historical wager database 22118.

FIG. 223 illustrates the base wagering module 22120. The process begins with the base wagering module 22120 being, at step 22300, initiated by user login via the wagering app 22126, login includes at least a user ID, in some embodiments login may include security credentials such as a password. For example, user Brandon Marcus is watching a football game and logins in with his username “bmarcus” in order to make wagers. The base wagering module 22120 retrieves, at step 22302, the available wagers for the current play of the live event 22102 from the odds calculation module 22112, in an embodiment wagers and odds may be retrieved from a third party. The base wagering module 22120 prompts, at step 22304, the wager offer module 22122 for a wager window which is a time frame within which wagers can be placed. The wager offer module 22122 returns to the base wagering module 22120 with a wager window the current available wagers. The base wagering module 22120 displays, at step 22306, the available wagers for the current play, the associated odds for each wager, and a time remaining, or time estimated to remain, or designated time to remain, or some other indicia indicating an amount of time, either estimated, designated, or determined, to make a wager. For example, user “bmarcus” may see on his wagering app 22126, two wager options, “pass” with 1 to a odds and “run” with 2 to 3 odds, and a timer that counts downward until the betting window closes. It may be appreciated, that the timer, however, may not be a literal representation of time, but some other indicia. For example, at a time when a wager is first offered (and a team may be organizing or going to a huddle), a green indicia or frame on a display showing a first amount of time available to place a wager, then when a team breaks a huddle or some other amount of time has passed, a second indicia such as a yellow indicia or frame on a display may be provided, then when a quarterback (in a football example) moves into position under center or in a shotgun formation, a final indicia, such as a red indicia or red frame on a display, may be provided to show that there may not be a significant amount of time left to place a wager or otherwise encourage wagers to be made soon. It can be appreciated that the indicia may be any of visible, audible, or haptic indicia, or any combination thereof. The base wagering module 22120 prompts, at step 22308 (and perhaps using some indicia), the user to select one of the available wagers, in an embodiment this selection process may be facilitated by a GUI within the wagering app 22126. For example, user “bmarcus” wagers $20 that the next play will be a pass. The base wagering module 22120 receives, at step 22310, the user's selection of wager for the current play and the amount of money the user has wagered. For example, user Brandon Marcus is sure the next play is going to be a pass, he selects the wager option for “pass” and wagers $20. The base wagering module 22120 polls, at step 22312, for the close of the wagering window. The wagering window will be closed at the start of the play of the game that users have placed bets on, which may coincide or come shortly after some other indicia indicating an end to the wagering window time is occurring. The wagering window may also be closed by some event which strongly indicates the next play is about to start, for example, in football a team breaking a huddle or in baseball the batter stepping out of the box or the pitcher stepping off the rubber are strong indicators that the play is about to begin, these events alone may close the window immediately or within a few seconds, or may result in other indicia being provided that may indicate a wagering window will be closing within a known amount of time or within an unknown, but imminent, time. In some embodiments other elements of the game may also be taken into account, for example, if there is a runner on base then the pitcher stepping off the rubber will close the window in 5 seconds but if there is no runner on base then the pitcher stepping off the rubber will close the window in 8 seconds. In an embodiment the wagering window will close at the end of the estimated remaining wager window time if the end of the estimated remaining wager window time occurs before any other event that would close the wagering window. The base wagering module 22120 polls, at step 22314, for completion of the current play of the live event 22102. The base wagering module 22120 compares, at step 22316, the actual results of the play of the live event 22102 to the user's wager selection. For example, if user “bmarcus” wagered that the next play would be a pass, and the play was in fact a pass, then the user won the wager. The base wagering module 22120 adjusts, at step 22318, the user's balance in the user database 22110 based on whether the wager was won or lost, in an embodiment a third party will instead handle user balance and payments. For example, user “bmarcus” will receive $20 dollars added to their balance because they bet $20 and won with 1:1 odds, if the $20 wagered was already removed from the account balance that amount will be returned. The base wagering module 22120 updates, at step 22320, the historical wager database 22118 with a new entry for the user's wager. For example, a new entry will be created with the user “bmarcus”, the live game ID, the play bet on, that user “bmarcus” won, the time the bet was made, etc. The base wagering module 22120 determines, at step 22322, if the live event 22102 is complete via data from the sensor feeds 22104, in some embodiments the end of the live event 22102 may be manually determined or determined by another module. If the live event 22102 is not complete, the base wagering module 22120 returns, at step 22324, to step 22302. If the live event 22102 is complete, the base wagering module 22120 ends, at step 22326.

FIG. 224 illustrates the wager offer module 22122. The process begins with the wager offer module 22122 being, at step 22400, initiated by the base wagering module 22120. In some embodiments the base wagering module 22120 may also send data on the current state of the live event 22102 and the wager offer module 22122 may skip to step 22404. The wager offer module 22122 retrieves, at step 22402, data on the current state of the live event 22102 from the sensor 22104. For example, from the sensor 22104 the wager offer module 22122 would know that the live event 22102 is an American football game between the Pittsburgh Steelers and the New England Patriots, the Steelers are on offence with a third down and two yards to go for a first down with five minutes to go in the third quarter. The wager offer module 22122 searches, at step 22404, the historical play database 22114 for plays with data that is similar to the data retrieved from the sensor 22104. Similar data may mean that a high number of parameters are exactly the same or within a certain threshold of one another, this number may be pre-set, or determined dynamically via the results of the search. For example, if the current play data indicates that the live event 22102 is an American football game between the Pittsburgh Steelers and the New England Patriots, the Steelers are on offence with a third down and two yards to go for a first down with five minutes to go in the third quarter and the weather is overcast, then a similar play may be a play that occurred during a football game, wherein the Steelers were on offense, the Patriots were on defense, it was second down and three yards with four minutes to go in the third quarter, and the weather was overcast with light rain. In some embodiments the results of the search may be given a similarity score which may be used to determine how much weight each result should contribute to the estimated remaining time before the start of the next play. The wager offer module 22122 extracts, at step 22406, the identifying information from the similar plays returned by the search of the historical play database 22114, which includes at least a play ID and live game ID, or some other unique identify which can be used to identify an individual play of a live event 22102. For example, if the live event 22102 is an American football game between the Pittsburgh Steelers and the New England Patriots on Sep. 8, 2019, then the live game ID may read “Steelers_Patriots_090819” and if the Steelers are on offence with a third down and two yards to go for a first down with five minutes to go in the third quarter then the play ID may read “Steelers_1st_and2_3Q” or more simply if that play is the 23rd play of the game then the play ID may read “23”. The wager offer module 22122 searches, at step 22408, the historical wager database 22118 for using the identifying data extracted from the historical play database 22114. For example if the live event 22102 is an American football game between the Pittsburgh Steelers and the New England Patriots, the Steelers are on offence with a third down and two yards to go for a first down with five minutes to go in the third quarter, this search would return all wagers placed on that play of that game. The wager offer module 22122 estimates, at step 22410, the time remaining before the next play from the difference between the start of the play and the end of the last play for each similar play, then taking an average. For example, the current play of the game is similar to only two other plays, the first similar play began at 8:41:22 PM and the play before it ended at 8:40:22, the second similar play began at 1:44:55 PM and began at 1:44:25 PM, the time between the first similar play and the preceding play was 60 seconds, and the time between the second similar play and the preceding play was 30 seconds, therefore the estimated time before the next play of the live game 22102 is 45 seconds after the end of the last play. In another embodiment other statistical averages may be used other than the mean, such as the mode or median, or other statistical identities may be used. In some embodiments certain plays may be given more weight when computing the average, for example if play are given a score based on similarity then more similar plays may contribute more to the average, in another example shorter time between plays may be weighted more so that the estimate is more conservative and less likely to be longer than the actual time between the last play of the live game 22102 and the next one. In some embodiments specific parameters of the live game 22102 or the play may be controlling, for example, in baseball the pitcher's average time between pitches is a commonly known statistic and that statistic may be used in place of the average, for another example if there is only a certain amount of time left in the live event 22102 or a portion of the live event 22102, such as a quarter, then that time left may be limit the maximum estimate, for example if there are 30 seconds on the clock left in the first quarter of a football game and the clock is running, then the estimate may be no more than 30 seconds, in another example, if a team needs to score in order to win the game the estimate may be adjusted to account for that urgency. The wager offer module 22122 sends, at step 22412, the estimated time remaining before the next play to the base wagering module 21220, for example, 45 seconds. The wager offer module 22122 returns, at step 22414, to the base wagering module 22120.

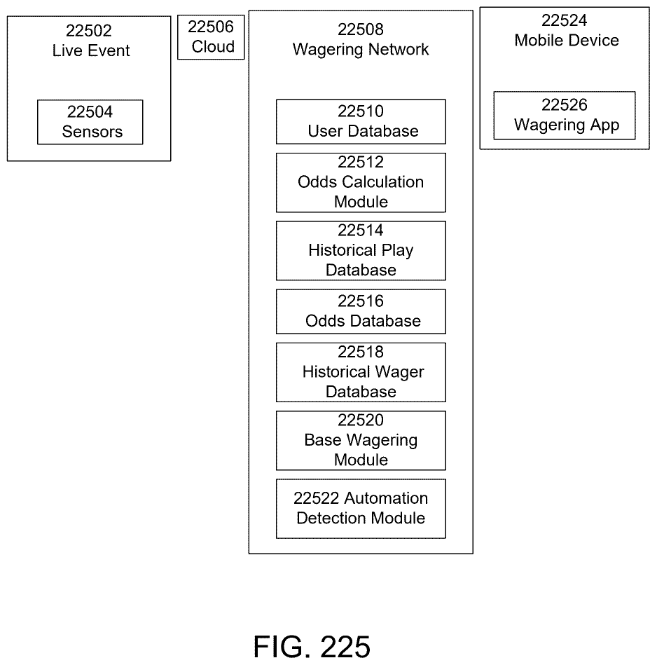

FIG. 225 illustrates a system for automated wager detection, according to an embodiment.

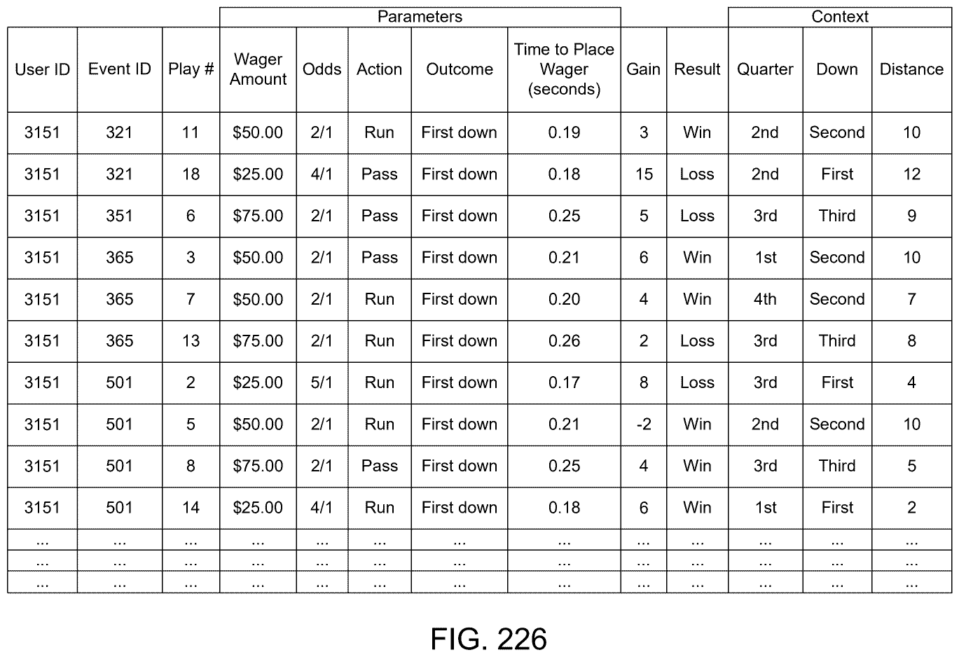

FIG. 226 illustrates a historical wager database, according to an embodiment.

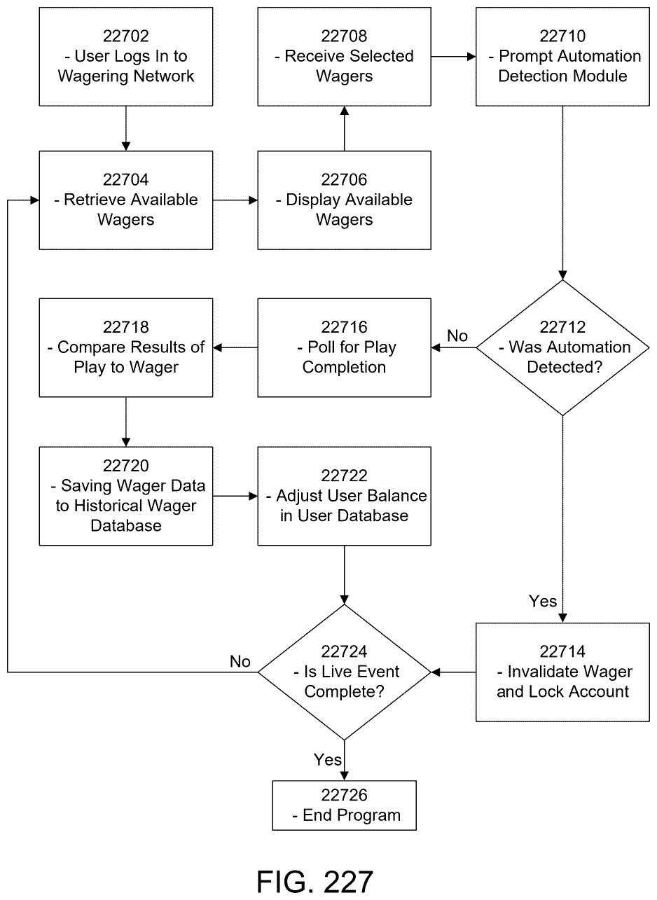

FIG. 227 illustrates a base wagering module, according to an embodiment.

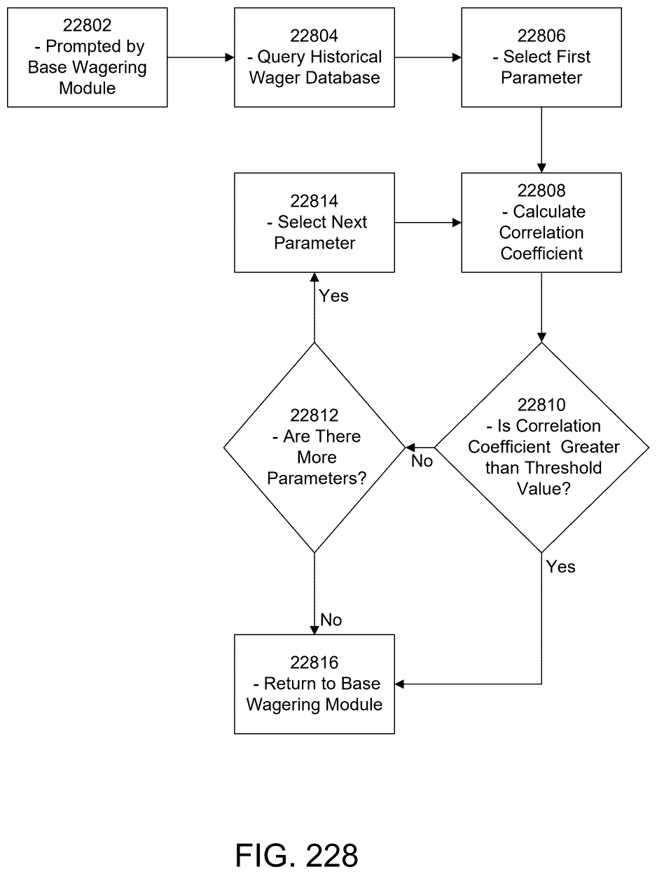

FIG. 228 illustrates an automation detection module, according to an embodiment.

FIG. 225 displays a system for automated wager detection. This system is comprised of a live event 22502, for example a sporting event such as a football game, basketball game, baseball game, hockey game, tennis match, golf tournament, eSports or digital game, etc. The live event 22502 will include some number of actions or plays, upon which a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game was the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 22502, such as the score of American football or the run line in baseball, or a series of action in the live event 22502. Sportsbooks have a number of bets they can handle and a limit of wagers they can take on either side of a bet before they will move the line or odds off of the opening line. Additionally, there are circumstance, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live event 22502 in the future. Sportsbooks need to offer payment processing services in order to cash out customers. This can be done at kiosks at the live event 22502 or at another location.

Further, embodiments may include a plurality of sensors 22504 that may be used such as motion sensors, temperature sensors, humidity sensors, cameras such as an RGB-D Camera which is a digital camera capturing color (RGB) and depth information for every pixel in an image, microphones, a radiofrequency receiver, a thermal imager, a radar device, a lidar device, an ultrasound device, a speaker, wearable devices etc. Also, the plurality of sensors 22504 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball.

Further, embodiments may include a cloud 22506 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, which may occur over Internet and relies on sharing of resources to achieve coherence and economies of scale, like a public utility, while third-party clouds enable organizations to focus on their core businesses instead of expending resources on computer infrastructure and maintenance. The cloud 22506 may be communicatively coupled to a wagering network 22508 which may perform real time analysis on the type of play and the result of the play. The cloud 22506 may also be synchronized with game situational data, such as the time of the game, the score, location on the field, weather conditions, and the like which may affect the choice of play utilized. For example, in an exemplary embodiment, the cloud 22506 may not receive data gathered from sensors 22504 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein.

Further, embodiments may include the wagering network 22508 which may perform real time analysis on the type of play and the result of a play or action. The wagering network 22508 (or cloud 22506) may also be synchronized with game situational data, such as the time of the game, the score, location on the field, weather conditions, and the like which may affect the choice of play utilized. For example, in an exemplary embodiment, a wagering network 22508 may not receive data gathered from sensors 22504 and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein. The wagering network 22508 may offer any of a number of different software as a managed service such as, user interface service, risk management service, compliance, pricing and trading service, IT support of the technology platform, business applications, game configuration, state based integration, fantasy sports connection, integration to allow the joining of social media, and marketing support services that can deliver engaging promotions to the user.

Further, embodiments may utilize a user database 22510 which contains data relevant to all users of the system, which may include, a user ID, a device identifier, a paired device identifier, wagering history, and wallet information for each user.

Further, embodiments may include an odds calculation module 22512 which utilizes historical play data to calculate odds for in-play wagers.

Further, embodiments may include a historical play database 22514, that contains play data for the type of sport being played in the live event 22502. For example, in American Football, for optimal odds calculation, the historical play data should include meta data about the historical plays, such as time, location, weather, previous plays, opponent, physiological data, etc.

Further, embodiments may utilize an odds database 22516 that contains the odds calculated by the odds calculation module 22512, and multipliers for distance and path deviation, and is used for reference by a base wagering module 22520 and to take bets from the user through a user interface and calculate the payouts to the user.

Further, embodiments may utilize a historical wager database 22518 that contains wagers from live events 22502. Wagers may include a wager amount, odds, and an outcome such that a payout in the amount of the wager amount multiplied by the odds will be paid to a user if the outcome wagered on occurs, otherwise the wager amount being lost. The historical wager database 22518 may additionally contain contextual data about the state of a live event 22502 when the wager was placed.

Further, embodiments may include the base wagering module 22520 which allows a user to log into the wagering network 22508, retrieves available wagers from the odds database 22516 and displays available wagers to a user. The base wagering module 22520 prompts an automation detection module 22522 which returns whether automation was detected in the placing of the received wager. The automation detection module 22522 invalidates the received wager if automation is detected. If automation is not detected, automation detection module 22522 polls for play completion, and compares the results of the play to the wager. automation detection module 22522 saves the results of the wager to the historical wager database 22518 and adjusts the user's balance in the user database 22510 based on the results of the wager. automation detection module 22522 checks whether the live event 22502 is complete and ends the program if the live event 22502 is complete.

Further, embodiments may include the automation detection module 22522 which receives a prompt with a wager from the base wagering module 22520 and contextual information about a live event 22502 from sensors 22504. The automation detection module 22522 queries the historical wager database 22518 for a user's past wagers and filters the past wagers by contextual information about the live event 22502 and selects a parameter. The automation detection module 22522 calculates correlation coefficients for pairings of the selected parameter with each parameter not selected and compares the correlation coefficients to a threshold value. If a correlation coefficient is greater than the threshold value, the automation detection module 22522 returns to the base wagering module 22520 that automation has been detected, otherwise it continues checking whether there are additional parameters which have not been evaluated for correlation, selects one of the parameters, and repeats the steps of calculating and comparing correlation coefficients to a threshold value. If none of the correlation coefficients are greater than the threshold value and there are no remaining parameters to evaluate for correlation, the automation detection module 22522 returns to the base wagering module 22520 that automation was not detected.

Further, embodiments may include a mobile device 22524 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices provide for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 22524 could be an optional component and would be utilized in a situation in which a paired wearable device is utilizing the mobile device 22524 as additional memory or computing power or connection to the internet.

Further, embodiments may include a wagering app 22526, which is a program that enables the user to place bets on individual plays in the live event 22502, and display the audio and video from the live event 22502, along with the available wagers on the mobile device 22524. The wagering app 22526 allows the user to interact with the wagering network 22508 in order to place bets and provide payment/receive funds based on wager outcomes.

FIG. 226 displays the historical wager database 22518. The historical wager database 22518 stores data about wagers placed by users during a live event 22502 including prior events. The data may include any of a user ID, wager amount, odds, and outcome. The user ID identifies the user of a wagering network 22508 who placed the wager, a wager amount is a monetary value wagered by the user and the odds are the multiple by which the wager amount will be increased to calculate a payout if the wager is won. A wager is won if the outcome, the result of a play wagered upon by the user, occurs. The historical wager database 22518 may further include situational context about the live event 22502 when the wager was placed. In an American football game, the situation context data may include the quarter, down and distance to first down or goal. The historical wager database 22518 is populated by the base wagering module 22520 and is used by the automation detection module 22522 to calculate the correlation coefficient for parameters of a user's past and present wagers to be compared against a threshold value such that a correlation coefficient greater than the threshold value indicates automation was used to place a wager.

FIG. 227 displays the base wagering module 22520. The process begins with a user logging into, at step 22702, the wagering network 22508 via a user interface by entering a username and a password. In an embodiment, the username is an email address and the password is a combination of alphanumeric characters. The base wagering module 22520 retrieves, at step 22704, the currently available wagers from the odds database 22516. The wagers include an outcome and odds such that the outcome is the condition which must be met during the play to win the wager and the odds represent the multiple by which the wager amount placed by a user will be multiplied to determine the payout due to the user if the wager is won. The base wagering module 22520 displays, at step 22706, the available wagers to a user via a wagering app 22526 on a mobile device 22524. The wagers including an outcome and odds. The wagers may additionally include a default wager amount. The base wagering module 22520 receives, at step 22708, at least one wager from a user from the available wagers. The wager includes a wager amount, outcome and odds. In an American football game between the New England Patriots and the New York Giants, user Joe Smith wagers $50 at odds of 5/1 that the New England Patriots will convert a second and 8 for a first down with 5 minutes remaining in the third quarter. The wager is placed 0.21 seconds after the available wagers were displayed to the user Joe Smith. The base wagering module 22520 prompts, at step 22710, the automation detection module 22522 with the wager received from a user. The automation detection module 22522 additionally receives contextual data about the live event 22502 from sensors 22504 and queries the historical wager database 22518 for the user's past wagers. The automation detection module 22522 filters the user's past wagers for contextual information, such as the current state of the live event 22502 and selects a parameter. The automation detection module 22522 calculates correlation coefficients for each pairing of the selected parameter with each other parameter not selected and compares the correlation coefficients to a threshold value. The automation detection module 22522 determines that automation was used to place wagers if a correlation coefficient exceeds the threshold value. If none of the correlation coefficients exceed the threshold value, the automation detection module 22522 selects another parameter if there are more that have not been evaluated for correlation, and repeats the steps of calculating correlation coefficients and comparing the correlation coefficients to the threshold value. The automation detection module 22522 determines that automation was not used to place wagers if no correlation coefficients exceed the threshold value and there are no more parameters which have not been evaluated for correlation. The automation detection module 22522 returns the determination of whether automation was or was not detected to the base wagering module 22520. The base wagering module 22520 receives, at step 22712, whether automation was detected from the automation detection module 22522. In the example, the automation detection module 22522 identifies that automation was used to place wagers. The base wagering module 22520 invalidates, at step 22714, the wager if automation is detected by the automation detection module 22522 and further may lock the user's account. Having detected trends in historical data indicating a history of using automation to place wagers, the base wagering module 22520 may prevent continued use of the detected automation by preventing the user's account from placing additional wagers. In the example, the user Joe Smith's account has been determined to be using automation to place wagers and therefore the current wager is deemed invalid and the wager amount debited from the user Joe Smith's account is refunded. The user Joc Smith's account is additionally locked, preventing additional wagers from being placed. A notification may further be provided to user Joe Smith that the wager was invalidated and the account locked. The account may be locked for a duration which may be defined by the administrator of the wagering network 22508 or alternatively require the user to take an action to unlock the account to confirm that they are a human. The base wagering module 22520 polls, at step 22716, the sensors 22504 for play completion. Completion of the play indicates that result of the play can be acquired and compared to the outcome wagered on by the user. In the example, the play is complete when at least one referee blows their whistle when a player carrying the ball for a run for the New England Patriots runs out of bounds. The base wagering module 22520 compares, at step 22718, the results of the play to the outcome wagered on by the user. The wager is won if the results of the play match the outcome wagered on by the user, while the wager is lost if the results of the play and the outcome wagered on by the user are different. In the example, the play resulted in a gain of 3 yards on a run for the New England Patriots resulting in third down and 5 yards to a first down. The user Joe Smith, having wagered $50 at 5/1 odds that the Patriots would convert second down and 8 yards for a first down, lost the wager as the Patriots did not convert for a first down during the play. The base wagering module 22520 saves, at step 22720, wager data to the historical wager database 22518. The wager data may include wager amount, odds, outcome, contextual information about the live event 22502 and metadata from the wager such as the time taken to place the wager. The wager data may further include the result of the wager, such as whether the wager was won or lost and the payout or loss resulting from the wager. The saved data allows the automation detection module 22522 to include the wager data in future determinations of whether automation is being used by the user's account. The base wagering module 22520 adjusts, at step 22722, the account balance of the user in the user database 22510 based on the results of the wager. If the wager is won, then the account balance is increased in an amount equal to the payout. They payout is determined based upon the odds accepted when the user placed the wager. In the example the odds are 5/1 and the wager amount is $50, so the payout would be $250. If the wager amount was not debited from the account balance prior to play completion, then the account balance is adjusted by the difference between the wager amount and payout. Similarly, if the wager was lost and the wager amount was not previously debited from the account balance, the account balance is reduced by the wager amount. The base wagering module 22520 polls, at step 22724, the sensors 22504 for whether the live event 22502 is complete. If the live event 22502 is not complete, the base wagering module 22520 returns to step 22704 and repeats the program. The program ends at step 22726 if the live event 22502 is complete.

FIG. 228 displays the automation detection module 22522. The process begins with the automation detection module 22522 receiving, at step 22802, a prompt from the base wagering module 22520 including at least one wager placed by a user. The wager includes an outcome, odds and wager amount and may also include the time taken to place the wager. Additionally, the automation detection module 22522 receives contextual information about the current state of the live event 22502 from the sensors 22504. In this example, the live event 22502 is an American football game and the contextual information may include, but is not limited to, any of the current down such as first, second, third or fourth, and the number of yards to a first down or goal, time left in the game, quarter, the score, the teams involved, the players on the field, the formation of the offense and defense, etc. The automation detection module 22522 queries, at step 22804, the historical wager database 22518 for the user's historical wager data. The historical wager data may include any of wager amounts, odds, outcomes, context of the live event 22502 such as the period during which the wager was placed, and metadata such as the time taken to place a wager. In the example, the automation detection module 22522 retrieves all wager data from past wagers placed by the user Joe Smith. The automation detection module 22522 selects, at step 22806, a first parameter from the available parameters from the historical wager data. The parameter may include, but is not limited to, any of wager amount, odds, an outcome, contextual information from a live event 22502 or additional metadata such as the amount of time taken to place a wager, etc. The amount of time taken to place a wager is the time elapsed from when the available wagers are displayed to the user and the wager is placed by the user. In this example, the selected parameter is the wager amount. The automation detection module 22522 calculates, at step 22808, a correlation coefficient for each pairing of the selected parameter and each unselected parameter. The correlation coefficient is a measure of the correlation between the selected parameter and a second parameter which can indicate the degree of influence of one parameter on the other. The closer a correlation coefficient is to 1, the stronger the implied influence. In the example, the correlation coefficient of wager amount and the time taken to place a wager is 0.96. The automation detection module 22522 compares, at step 22810, the correlation coefficients to a threshold value to determine whether automation is being used to place wagers. Automation is indicated if any correlation coefficient exceeds the threshold value as the parameters with a high correlation coefficient are likely being used by a program to place wagers. Lower correlation coefficients are expected from human users as humans are less precise or consistent than a computer program. The threshold value may be defined by the administrator of a wagering network 22508 or may be determined by an algorithm. A higher threshold value will be less prone to false positives but may take longer to detect the use of automation, while a lower threshold value may identify some human activity as using automation. In the example, a user Joc Smith submitted a wager for $50 at odds of 5/1 that the New England Patriots will convert second and 8 for a first down. The wager being placed 0.21 seconds after available wagers were offered to the user Joe Smith. The automation detection module 22522 retrieves the user Joc Smith's wager history from the historical wager database 22518. Wager amount is selected as a first parameter and a correlation coefficient is calculated for wager amount and each remaining parameter for the user Joe Smith's past wagers during American football games. When comparing the correlation coefficients to a threshold value of 0.95, which was predefined by an administrator of the wagering network 22508, the automation detection module 22522 identifies the correlation coefficient of wager amount and time taken to place wagers as 0.96 which is greater than the threshold value of 0.95. The wager amount of $50 was so frequently wagered at 0.21 seconds after available wagers were offered, that it must be assumed that a robotic process is at work as humans are unlikely to wager with such consistent timing. It is therefore determined that automation has been used to place wagers for the user Joe Smith. It should be understood to those skilled in the arts that there are other methods of detecting automation in in-play betting, such as an extended winning streak that exceeds the likelihood of being done by a human. A robotic system may also build in systemic errors in order to hide the robotic process from the automation detection system. The automation detection module 22522 checks, at step 22812, if there are more parameters which have not been evaluated for correlation if none of the correlation coefficients for the previously selected parameter are greater than the threshold value. Each parameter should be evaluated for correlation with each other parameter, and if this condition is not met, then another parameter which has not been evaluated should be selected and the previous two steps repeated with the new selected parameter. In the example, if none of the correlation coefficients calculated for wager amount and each other parameter exceed the threshold value of 0.95, the automation detection module 22522 identifies that at least the odds parameter has not been evaluated for correlation. the automation detection module 22522 selects, at step 22814, the next parameter which has not been evaluated for correlation. The next parameter is taken from the available parameters from the historical wager data. The automation detection module 22522 further returns to step 22808 to calculate correlation coefficients for each pairing of the now selected odds parameter and all unselected parameters. In the example, the automation detection module 22522 selects the odds parameter, as it has not been evaluated for correlation and returns to step 22808. The automation detection module 22522 returns, at step 22816, to the base wagering module 22520 with whether automation was detected or not. In the example, automation was detected because the correlation coefficient of wager amount and time taken to place wagers was 0.96 which exceeded the 0.95 threshold value used to indicate the level of correlation expected from a program versus a human user.

In a further embodiment, if automation is detected, a notification may be displayed to the user that a current wager placed using automation is invalid, one or more previous wagers made by a user using automation have been invalidated, and/or that a user is prevented from making further wagers. Further, a user or an account could receive a displayed notification that an account associated with one or more automated wagers is locked and further action must be taken to reopen or reauthorize the account. Additionally, any notification regarding the invalidation of one or more wagers placed (or suspected of being placed) using automation, may be accompanied by a notification or listing of any related terms of service of the wagering app 22526 or wagering game and may indicate a violation of the terms of service.

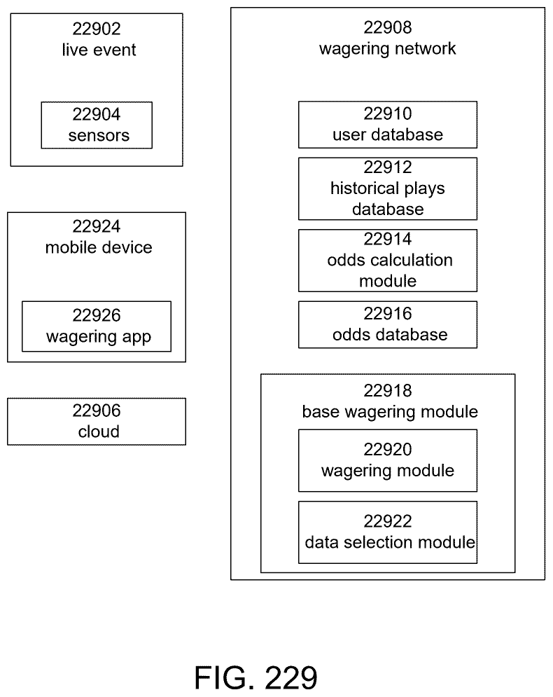

FIG. 229 illustrates a system for in-play wagering through a wagering network, according to an embodiment.

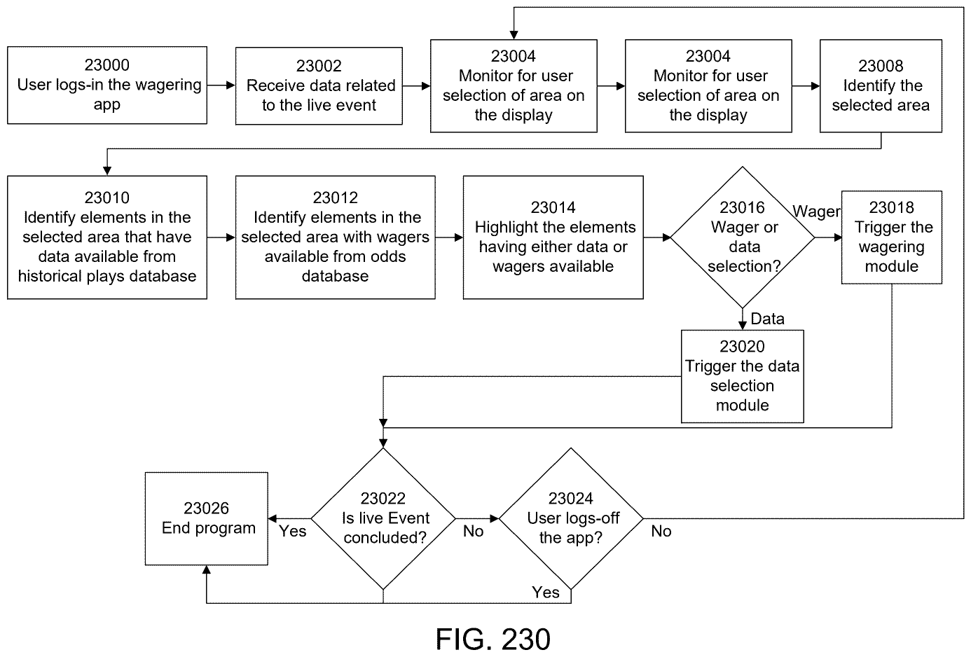

FIG. 230 illustrates a base wagering module, according to an embodiment.

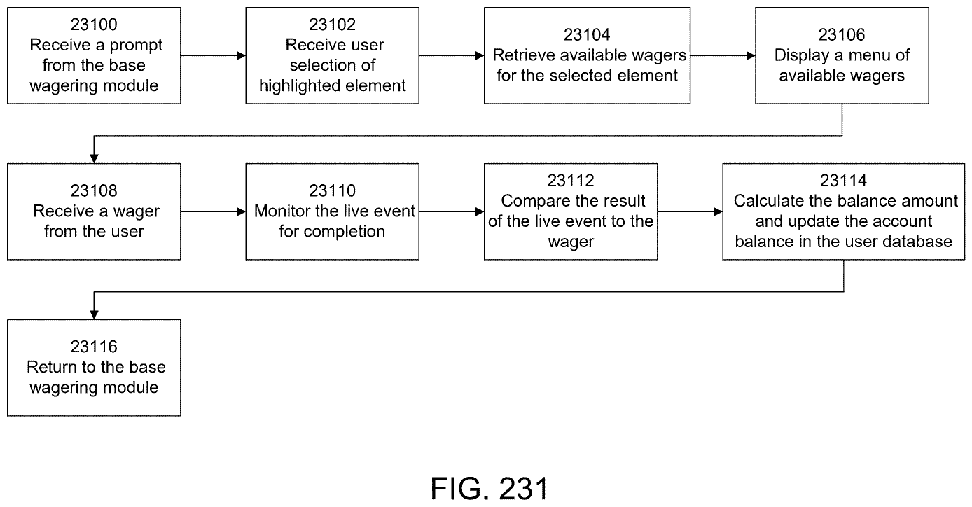

FIG. 231 illustrates a wagering module, according to an embodiment.

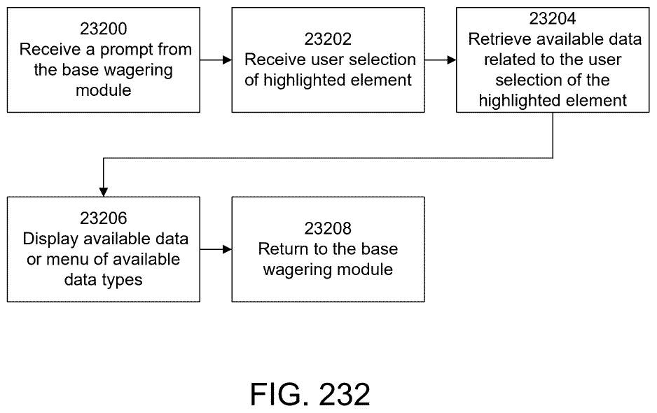

FIG. 232 illustrates a data selection module, according to an embodiment.

FIG. 229 displays a system for in-play wagering through a wagering network 22908. This system includes a live event 22902, for example, a sporting event such as an American football game, a basketball game, a hockey game, a tennis match, golf tournament, eSports or digital game, etc. The live event 22902 will include some number of actions or plays, upon with a user or bettor or customer can place a bet or wager, typically through an entity called a sportsbook. There are numerous types of wagers the bettor can make, including, a straight bet, a money line bet, a bet with a point spread or line that bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round-robin, or other styles of tournaments. There are other types of wagers, including parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 22902, such as the score of American football or the run line in baseball, or a series of action in the live event 22902. Sportsbooks have a number of bets they can handle and a limit of wagers they can take on either side of a bet before they will move the line or odds off of the opening line. Additionally, there are circumstances, such an injury to an important player such as a listed pitcher, in which a sportsbook, casino or racino will take an available wager off the board. As the line moves there becomes an opportunity for a bettor to bet on both sides at different point spreads to middle and win both bets. Sportsbooks will often offer bets on portions of games, such as first half bets and half-time bets. Additionally, the sportsbook can offer futures bets on live events 22902 in the future. Sportsbooks need to offer payment processing services to cash out customers. This can be done at kiosks at the live event 22902 or another location. For example, considering a live event 22902 being a baseball game that is played between the New York Yankees and the Los Angeles Dodgers, at Yankee Stadium, New York City.

Further, embodiments may include a plurality of sensors 22904 that may be used such as motion sensors, temperature sensors, humidity sensors, cameras such as an RGB-D camera which is a digital camera capturing color (RGB) and depth information for every pixel in an image, microphones, radiofrequency receiver, a thermal imager, a radar device, a LIDAR device, an ultrasound device, a speaker, wearable devices etc. Also, the plurality of sensors 22904 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that collects statistical information through real-time X, Y positioning of players and X, Y, Z positioning of the ball. In the example of baseball game, the plurality of sensors 22904 may be used for capturing parameters such as spin rate of the ball, ball positions, launch angle, and exit velocity.

Further, embodiments may include a cloud 22906 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable resources and higher-level services that can be rapidly provisioned with minimal management effort, often over internet and relies on sharing of resources to achieve coherence and economics of scale, like a public utility, while third-party clouds enable organizations to focus on their core businesses instead of expending resources on computer infrastructure and maintenance. The cloud 22906 may be communicatively coupled to the wagering network 22908 which may perform real time analysis on the type of play and the result of the play. The cloud 22906 may also be synchronized with game situational data, such as the time of the game, the score, location on the field, weather conditions, and the like which may affect the choice of play utilized. For example, in other embodiments, the cloud 22906 may not receive data gathered from sensors 22904 and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various embodiments herein.

Further, embodiments may include the wagering network 22908 which may perform real-time analysis on the type of play and the result of a play or action. The wagering network 22908 (or cloud 22906) may also be synchronized with game situational data, such as the time of the game, the score, location on the field, weather conditions, and the like which may affect the choice of play utilized. For example, in other embodiments, the wagering network 22908 may not receive data gathered from sensors 22904 and may, instead, receive data from an alternative data feed, such as SportsRadar®. This data may be compiled substantially immediately following the completion of any play and the data from this feed may be compared with a variety of team data and league data based on a variety of elements, including down, possession, score, time, team, and so forth, as described in various embodiments herein. The wagering network 22908 can offer a number of software as a service managed services such as, user interface service, risk management service, compliance, pricing and trading service, IT support of the technology platform, business applications, game configuration, state-based integration, integration to allow the joining of social media, as well as marketing support services that can create engaging promotions to the user. In one embodiment, the wagering network 22908, via a wagering app 22926, may facilitate settlement options to the user. In another embodiment, the wagering network 22908 may use third party balance settlement apps. For example, the wagering app 22926 may use Paypal for settlement of the balances of the user.

Further, embodiments may utilize a user database 22910 which contains data relevant to all users of the wagering network 22908, which may include, a user ID, a device identifier, a paired device identifier, wagering history, and wallet information for the user. The user database 22910 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 22910 may contain betting lines and search queries. The user database 22910 may be searched based on a search criteria received from the user. Each betting line may include a plurality of betting attributes such as at least one of the live event 22902, a team, a player, an amount of wager, etc. The user database 22910 may include information related to all the users involved in the live event 22902. In one example embodiment, the user database 22910 may include information for generating a user authenticity report and a wagering verification report. Further, the user database 22910 may be used to store user statistics like, but not limiting to, retention period for a particular user, frequency of wagers placed by a particular user, average amount of wager placed by each user.

Further, embodiments may utilize a historical plays database 22912 that contains play data for the type of sport being played in the live event 22902. In one embodiment, for optimal odds calculation and displaying data related to various elements such as individual players, the historical play data should include metadata about the historical plays, such as time of the live event 22902, location, weather, previous plays, opponent, physiological data of the players (including blood pressure, pulse rate, and respiration rate), information related to the players such as injuries in the past, information related to trainers of each player, etc. For example, the historical plays database 22912 may include information related to last 5 games, last 10 years, on a particular ground or field or stadium, etc. In one embodiment, the historical plays database 22912 may also be referred to as data analytics database. Further, the historical plays database 22912 may store analytics data such as player statistics including batting average, earned run average, catch probability, spin rate, launch angle, exit velocity, etc. In one embodiment, the historical plays database 22912 may store information in the form of a bar graph, a line graph, pictograph, a histogram, an area graph, or a scatter plot. Further, the historical plays database 22912 may store information related to a particular player involved in the live event 22902. The information may be, but not limiting to, an average score, a total score, etc. For example, in the baseball game, the physiological data related to Aaron Judge of New York Yankees, include his blood pressure at 140/90 mmHg and pulse rate at 62 beats per minute. In this example, the analytics data related to Aaron Judge of New York Yankees, such as batting average of −0.273, home runs total −120, runs batted in −267, etc.

Further, embodiments may include an odds calculation module 22914 which utilizes information from historical plays database 22912 and the information from the sensor feeds 22904 to calculate odds for in-play wagers. The information from the historical plays database 22912 may include data related to the type of the play, the previous information related to players involved in the live event 22902, and results of the previous live events 22902. The odds for each live event 22902, such as in a baseball game, a particular player hitting a home run, a single, or a strikeout, may be calculated based on the information received from the sensor feeds 22904 and the previous information related to the particular player. Further, the odds may be updated based on in-game events (for example, a player hits a home run with the same pitcher, decreasing his odds of getting a strikeout from the same pitcher). The odds may be calculated or adjusted based on statistical information related to the live event 22902 and the statistical information of the players. For example, the odds may be determined based on the historical data such as prior performance information about a player (like batting average against a certain pitcher, earned run average, catch probability, hamstring strain), and physiological information of player(s) etc., and current i.e. real-time information, such as current confidence level etc. In one embodiment, the type of wagering may depend on the type of game being played. In one embodiment, the odds calculation module 22914 may determine the available wagers to the user. The odds calculation module 22914 may also utilize a probability engine, which assembles all the historical data and real-time data and produces the odds (stored in the odds database 22916) for in-play wagers. Thus, the odds calculation module 22914 information relevant to all the potential outcomes, as available wagers, which facilitates the user with a better knowledge to make certain judgements about the potential performance of players in each live event 22902 and place a calculated wager with a potential return on the wager. For example, in baseball game, the odds calculation module 22914 may calculate odds related to the possible outcomes of an at-bat for Aaron Judge of New York Yankees hitting against the Clayton Kershaw of LA Dodgers, hitting a single are 4/1 (in money line +400), hitting a double are 5/1, hitting a home run are 3/1, and a strikeout are 2/1. In another example, in baseball game, the odds calculation module 22914 may calculate odds related to the possible outcomes of Clayton Kershaw of LA Dodgers, throwing a pitch inside the strike zone are 3/1.

Further, embodiments may utilize an odds database 22916 that contains the odds calculated by the odds calculation module 22914. The odds database 22916 stores all the odds and may be used to facilitate wagering opportunities to users through the wagering app 22926. In one embodiment, the type of wagering may depend on the type of game being played. Further, the odds database 22916 may store all the odds to be displayed on the display of the mobile device 22924.

Further, embodiments may include a base wagering module 22918 that allows the user to access the live event 22902, place wagers, or view data of various elements in the live event 22902. The base wagering module 22918 may allow the user to log-in/sign-in to the wagering network 22908 through the wagering app 22926 on a mobile device 22924, during the live event 22902. After logging in to the wagering app 22926, the base wagering module 22918 may receive data related to the live event 22902. It can be noted that the data related to the live event 22902 may be displayed on a display of the mobile device 22924. In another embodiment, the data may be displayed on a secondary screen controlled by the mobile device 22924. In one embodiment, the data related to the live event 22902, may be received from the sensor 22904. For example, in the baseball game, Aaron Judge of New York Yankees, playing 3rd innings against the Clayton Kershaw of LA dodgers. In another embodiment, the data may be related to wagers available for players. For example, the available wagers include a wager of $100 on Aaron Judge of New York Yankees, playing 3rd innings against the Clayton Kershaw of LA dodgers, hitting a single at odds of 4/1, a wager of $200 on Aaron Judge of New York Yankees, playing 3rd innings against the Clayton Kershaw of LA dodgers, hitting a homerun at odds of 2/1, and a wager of $400 on Clayton Kershaw of LA dodgers, playing 1st innings, or striking out at odds of 5/1. In another embodiment, the data may be related to physiological data of the players or information related to particular player. For example, in the baseball game, the physiological data related to Aaron Judge of New York Yankees, includes his blood pressure at 140/90 mmHg and pulse rate at 62 beats per minute. In this example, the analytics data related to Aaron Judge of New York Yankees, includes a batting average of—0.273, home runs total—22920, runs batted in—267, etc. After receiving the data related to the live event 22902, the base wagering module 22918 may continuously monitor a user selection of area on the display. Further, the base wagering module 22918 may receive the user selection of area for the display of the live event 22902 on the mobile device 22924. In one embodiment, the user may be able to use the touch screen of the mobile device 22924, which shows the video of the live event 22902, and the user may perform interactions (such as placing wager on a player or selecting a player to retrieve its data) with the video of the live event 22902. For example, the base wagering module 22918 receives the selected area of the display, when the user touches the display i.e. screen of the mobile device 22924 that shows video of the live event 22902. In this example, the user selects a particular area of the display, such as a top right corner of the display. Further, the base wagering module 22918 may identify the selected area. It can be noted that the base wagering module 22918 may take the user's selection of area on the display and translate the user selection of area, to determine which part of the field that corresponds to the user selection of area. For example, the base wagering module 22918 identifies the selected area including elements such as Aaron Judge (as hitter), Clayton Kershaw (as pitcher), and the base plate. Based on the identified selected area, the base wagering module 22918 may identify elements in the selected area that have data available from the historical plays database 22912. For example, the identified element includes Aaron Judge (as hitter) with data available such as information related to the previous baseball games played by the Aaron Judge of New York Yankees, batting average of 0.273, home runs total of 120, runs batted in −267, etc. Further, the base wagering module 22918 may identify elements in the selected area that have wagers available from the odds database 22916. For example, the identified elements, include Aaron Judge (as hitter) with wagers available from the odds database 22916, such as hitting a single are 4/1 at a wager of $100, hitting a double are 5/1 at a wager of $200, hitting a home run are 3/1 at a wager of $400, and a strikeout are 2/1 at a wager of $500. In this example, the identified element includes Clayton Kershaw (as pitcher) of LA Dodgers with wagers available such as throwing a pitch inside the strike zone are 3/1 at a wager of $100. In one embodiment, the base wagering module 22918 may use artificial intelligence (AI) or machine learning technology to identify elements, in the selected area, that have wagers or data available. Further, the base wagering module 22918 may highlight the elements that have either the data or wagers available. It can be noted that highlighted elements may be displayed on a display of the mobile device 22924. In this example, Aaron Judge (as hitter) and Clayton Kershaw (as pitcher) are highlighted on the display of the mobile device 22924, as data and wagers are available for these players. After highlighting the elements, the base wagering module 22918 may poll for data or wager selection. In this example, the user may either select to receive data related to Aaron Judge or the user may either select to place a wager on Aaron Judge. In one case, if the user selects to place a wager, then the base wagering module 22918 may trigger a wagering module 22920. In another case, if the user selects to receive the data, then the base wagering module 22918 may trigger a data selection module 22922. Thereafter, the base wagering module 22918 may constantly monitor if the live event 22902 is concluded or if the user logs-off from the wagering app 22926, during the live event 22902. In addition, at the end of the live event 22902, the user may be prompted with a message reminder for a next live event 22902, as a recommendation.

Further, embodiments may include a wagering module 22920 which is triggered when a wager is placed by the user in the live event 22902, via the base wagering module 22918. After receiving the prompt from the base wagering module 22918, the wagering module 22920 may receive a user selection of the highlighted element. For example, the user selects the highlighted player i.e. Aaron Judge of New York Yankees, playing 3rd innings against the Clayton Kershaw of LA dodgers. Further, the wagering module 22920, may retrieve available wagers for the selected element. In one embodiment, the wagering module 22920 may retrieve available wagers from the odds database 22916. In this example, the wagering module 22920 retrieves available wagers for Aaron Judge (as hitter) i.e. a wager of $100 on Aaron Judge playing hitting a single at odds 4/1 and a wager of $400 on Aaron Judge hitting a home run at odds 5/1 in the 3rd innings of the match between New York Yankees and LA dodgers. Further, the wagering module 22920 may display a menu of available wagers related to the selected element. In one embodiment, the menu may be displayed via the wagering app 22926, on the display of the mobile device 22924. In this example, the wagering module 22920 displays a menu of available wagers for Aaron Judge of New York Yankees hitting against the Clayton Kershaw of LA Dodgers in the 3rd innings of the match. The menu includes a wager of $100 on Aaron Judge playing hitting a single at odds 4/1 and a wager of $400 on Aaron Judge hitting a home run at odds 3/1. Further, the wagering module 22920 may receive a wager from the user. For example, the user places a wager of $100 on Aaron Judge of New York Yankees, playing 3rd innings against the Clayton Kershaw of LA dodgers, hitting a single at odds 4/1. Further, the wagering module 22920 may constantly monitor the live event 22902, for completion. In one case, when the live event 22902 is concluded, then the wagering module 22920 may proceed to obtain the results of the live event 22902. For example, the result of the live event 22902 is that Aaron Judge hits a single during the live event 22902. In another case, when the live event 22902 is not concluded, then the wagering module 22920 may continue monitoring the live event 22902 for completion. Further, the wagering module 22920 may compare the result of the live event 22902 with the wagers placed by the user, to determine a result i.e. whether the user has won or lost. In this example, the wager of $100 placed for Aaron Judge of New York Yankees, playing 3rd innings against the Clayton Kershaw of LA dodgers, hitting a single and the result of the live event 22902 i.e. Aaron Judge of New York Yankees, playing 3rd innings against the Clayton Kershaw of LA dodgers, hits a single, are compared to determine the result of the wager i.e. a win for the user. Based on the comparison of the result of the live event 22902 and the wagers placed by the user, the wagering module 22920 may calculate the balance amount for the user. For example, the user wins the wager of $100 at +400 odds that Aaron Judge will hit a single on the next play and the result of the live event 22902 is Aaron Judge hits a single. Thus, the updated balance of the user (with an opening balance of $2000), after the completion of the live event 22902, will be $2000+$400=$2400. Further, the wagering module 22920 may update, at step 312, the account balance of the user who places the wager in the user database 22910. In this example, after winning the wager of $100 placed (at odds of 4/1), the updated balance of the user i.e. $2400. Thereafter, the process returns to the base wagering module 22918. Further, embodiments may include a data selection module 22922 that allows the user to receive data related to the elements involved in the live event 22902. After receiving the prompt from the base wagering module 22918, the data selection module 22922 may receive a user selection of the highlighted element. For example, a user selects Aaron Judge of New York Yankees, playing 3rd innings against the Clayton Kershaw of LA dodgers. Further, the data selection module 22922 may retrieve the available data related to the user selection of the highlighted element. In one embodiment, the data may be retrieved from the historical plays database 22912. In this example, the data selection module 22922 retrieves data related to Aaron Judge (as hitter), such as batting average of 0.273, home runs total 20, runs batted in 67, etc. Further, the data selection module 22922 may display the available data or menu of available data types. In one embodiment, the data may be displayed on the display of the mobile device 22924. In one example embodiment, data types may correspond to different data sets available i.e. batting data set or pitching data set. It can be noted that the menu option may allow the user for a deeper dive into a type of data. In one embodiment, the data may be displayed in various forms such as drop-down menu, a bar graph, a line graph, pictograph, a histogram, an area graph, or a scatter plot. For example, the available data displayed to the user, corresponds to the previous baseball games played by the Aaron Judge of New York Yankees, batting average of 0.273, home runs total 20, runs batted in 67, etc. Thereafter, the process returns to the base wagering module 22918.

Further, embodiments may include a mobile device 22924 such as a computing device, laptop, smartphone, tablet, computer, smart speaker, or I/O devices. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. devices allow for voice recognition and inputs, including, e.g., Microsoft KINECT, SIRI for IPHONE by Apple, Google Now or Google Voice Search. Additional mobile devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also allow storage and/or an installation medium for the computing device. In still other embodiments, the computing device may allow USB connections (not shown) to receive handheld USB storage devices. In further embodiments, a I/O device may be a bridge between a system bus and an external communication bus, e.g. a USB bus, a SCSI bus, a FireWire bus, an Ethernet bus, a Gigabit Ethernet bus, a Fiber Channel bus, or a Thunderbolt bus. Further, the mobile device 22924 could be an optional component and would be utilized in a situation in which the paired wearable device is utilizing the mobile device 22924 as additional memory or computing power or connection to the internet.

Further, embodiments may include the wagering app 22926 which allows the user to place in-play wagers during the live event 22902. In one embodiment, the wagering app 22926 may be a mobile application or web application, which runs on the mobile device 22924. The wagering app 22926 may allow the user to receive data related to the live event 22902. For example, in the baseball game, Aaron Judge of New York Yankees, playing 3rd innings against the Clayton Kershaw of LA dodgers. In one embodiment, the wagering app 22926 may present the user with the wagers available, related to a particular live event 22902. Further, the wagering app 22926 may allow the user to place in-play wagers corresponding to the available wagers. In one embodiment, the wagering app 22926 may facilitate the user with an interface i.e. a graphical user interface (GUI) for performing various operations such as, but not limiting to, selecting a POV for viewing the live event 22902, linking other applications with the wagering app 22926, storing user's personal details, etc. In one embodiment, the wagering app 22926 may store information related to the placed wagers. In another embodiment, the wagering app 22926 may facilitate the user to enable setting reminders related to a particular live event 22902. Further, when the live event 22902 concludes, the wagering app 22926 may facilitate settlement of balances for the user. In another embodiment, the wagering app 22926 may trigger third party balance settlement apps linked to the wagering app 22926, for settlement of the balances of the user. For example, the wagering app 22926 may use Paypal for settlement of the balances of the user.

FIG. 230 illustrates the base wagering module 22918. The process begins with the base wagering module 22918 is triggered when the user logs-in, at step 23000, to the wagering network 22908 through the wagering app 22926, on the mobile device 22924. The base wagering module 22918 may facilitate the user to access the live event 22902, place wagers, or view data of various elements in the live event 22902. After logging in to the wagering app 22926, the base wagering module 22918 may receive, at step 23002, data related to the live event 22902. It can be noted that the data related to the live event 22902 may be displayed on a display of the mobile device 22924. In one embodiment, the data related to the live event 22902, may be received from the sensor feeds 22904. For example, in the baseball game, Aaron Judge of New York Yankees, playing 3rd innings against the Clayton Kershaw of LA dodgers. In another embodiment, the data may be related to wagers available for players. For example, the available wagers include a wager of $100 on Aaron Judge of New York Yankees, playing 3 innings against Clayton Kershaw of LA Dodgers, hitting a single at odds of 4/1, a wager of $200 on Aaron Judge of New York Yankees, playing 3 innings against the Clayton Kershaw of LA Dodgers, hitting a homerun at odds of 2/1, and a wager of $400 on Clayton Kershaw of LA Dodgers, playing 1st innings, scoring a strikeout at odds of 5/1. In another embodiment, the data may be related to physiological data of the players or information related to particular player. For example, in the baseball game, the physiological data related to Aaron Judge of New York Yankees, includes his blood pressure at 140/90 mmHg and pulse rate at 62 beats per minute. In this example, the analytics data related to Aaron Judge of New York Yankees, includes a batting average of −0.273, home runs total −120, runs batted in −267, etc. After receiving the data related to the live event 22902, the base wagering module 22918 may continuously monitor, at step 23004, a user selection of area on the display. Further, the base wagering module 22918 may receive, at step 23006, the user selection of area for the display of the live event 22902 on the mobile device 22924. For example, the base wagering module 22918 receives the selected area of the display, when the user touches the display i.e. screen of the mobile device 22924 that shows video of the live event 22902. In this example, the user selects a particular area of the display, such as a top right corner of the display. Further, the base wagering module 22918 may identify, at step 23008, the selected area. It can be noted that the base wagering module 22918 may take the user's selection of area on the display and translate the user selection of area, to determine which part of the field that corresponds to the user selection of area. For example, the base wagering module 22918 identifies the selected area including elements such as Aaron Judge (as hitter), Clayton Kershaw (as pitcher), and the base plate. Based on the identified selected area, the base wagering module 22918 may identify, at step 23010, elements in the selected area that have data available from the historical plays database 22912. For example, the identified element include Aaron Judge (as hitter) with data available such as information related to the previous baseball games played by the Aaron Judge of New York Yankees, batting average of 0.273, home runs total of 20, runs batted in 67, etc. Further, the base wagering module 22918 may identify, at step 23012, elements in the selected area that have wagers available from the odds database 22916. For example, the identified elements, include Aaron Judge (as hitter) with wagers available from the odds database 22916, such as hitting a single are 4/1 at a wager of $100, hitting a double are 5/1 at a wager of $200, hitting a home run are 3/1 at a wager of $400, and a strikeout are 2/1 at a wager of $500. In this example, the identified element includes Clayton Kershaw (as pitcher) of LA Dodgers with wagers available such as throwing a pitch inside the strike zone are 3/1 at a wager of $100. Further, the base wagering module 22918 may highlight, at step 23014, the elements that have either the data or wagers available. It can be noted that highlighted elements may be displayed on a display of the mobile device 22924. In this example, Aaron Judge (as hitter) and Clayton Kershaw (as pitcher) are highlighted on the display of the mobile device 22924, as data and wagers are available for these players. After highlighting the elements, the base wagering module 22918 may poll, at step 23016, for data or wager selection. In this example, the user may cither select to receive data related to Aaron Judge or the user may either select to place a wager on Aaron Judge. In one case, if the user selects to place a wager, then the base wagering module 22918 may trigger a wagering module 22920. In another case, if the user selects to receive the data, then the base wagering module 22918 may trigger a data selection module 22922. Based on the determination that the user selects to place the wager, the base wagering module 22918 may trigger, at step 23018, the wagering module 22920. Based on the determination that the user selects to receive data, the base wagering module 22918 may trigger, at step 23020, the data selection module 22922. Thereafter, the base wagering module 22918 may constantly monitor, at step 23022, the live event 22902 for completion. In one case, when the live event 22902 is concluded, then the base wagering module 22918 may again trigger the wagering module 22920, to conclude on the wagers placed by the user. In another case, when the live event 22902 is not concluded, then the base wagering module 22918 may return to, step 23004, for user selection of area on the display. Thereafter, the base wagering module 22918 may constantly monitor, at step 23024, if the user logs-off from the wagering app 22926, during the live event 22902. In one case, when the user logs-off from the wagering app 22926, then the base wagering module 22918 may again trigger the wagering module 22920, to conclude on the wagers placed by the user. In another case, when the user does not logs-off from the wagering app 22926, then the base wagering module 22918 may return to, step 23004, for user selection of area on the display. Thereafter, the program ends, at step 23026.

FIG. 231 illustrates the wagering module 22920. The wagering module 22920 may receive, at step 23100, a prompt from the base wagering module 22918. It can be noted that the wagering module 22920 is triggered when the user wants to place a wager during the live event 22902. For example, a user wants to place a wager on Aaron Judge of New York Yankees, playing 3 innings against the Clayton Kershaw of LA Dodgers. The wagering module 22920 may receive, at step 23102, a user selection of the highlighted element. For example, the user selects the highlighted player i.e. Aaron Judge. The Further, the wagering module 22920, may retrieve, at step 23104, available wagers for the selected element. In one embodiment, the wagering module 22920 may retrieve available wagers from the odds database 22916. In this example, the wagering module 22920 retrieves available wagers for Aaron Judge (as hitter) i.e. a wager of $100 on Aaron Judge playing hitting a single at odds 4/1 and a wager of $400 on Aaron Judge hitting a home run at odds 5/1 in the 3rd innings of the match between New York Yankees and LA dodgers. Further, the wagering module 22920 may display, at step 23106, a menu of available wagers related to the selected element. In one embodiment, the menu may be displayed via the wagering app 22926, on the display of the mobile device 22924. In this example, the wagering module 22920 displays a menu of available wagers for Aaron Judge of New York Yankees hitting against the Clayton Kershaw of LA Dodgers in the 3rd inning of the match. The menu includes a wager of $100 on Aaron Judge hitting a single at odds 4/1 and a wager of $400 on Aaron Judge hitting a home run at odds 3/1. Further, the wagering module 22920 may receive, at step 23108, a wager from the user. For example, the user places a wager of $100 on Aaron Judge of New York Yankees, playing 3rd innings against the Clayton Kershaw of LA dodgers, hitting a single at odds 4/1. Further, the wagering module 22920 may constantly monitor, at step 23110, the live event 22902, for completion. In one case, when the live event 22902 is concluded, then the wagering module 22920 may proceed to obtain the results of the live event 22902. For example, the result of the live event 22902 is that Aaron Judge hits a single during the live event 22902. In another case, when the live event 22902 is not concluded, then the wagering module 22920 may continue monitoring the live event 22902 for completion. Further, the wagering module 22920 may compare, at step 23112, the result of the live event 22902 with the wagers placed by the user, to determine a result i.e. whether the user has won or lost. In this example, the wager of $100 placed for Aaron Judge of New York Yankees, playing 3rd innings against the Clayton Kershaw of LA dodgers, hitting a single and the result of the live event 22902 i.e. Aaron Judge of New York Yankees, playing in the 3rd innings against the Clayton Kershaw of LA dodgers, hits a single, are compared to determine the result of the wager i.e. a win for the user. Based on the comparison of the result of the live event 22902 and the wagers placed by the user, the wagering module 22920 may calculate, at step 23114, the balance amount for the user. For example, the user wins the wager of $100 at +400 odds that Aaron Judge will hit a single on the next play and the result of the live event 22902 is Aaron Judge hits a single. Thus, the updated balance of the user (with an opening balance of $2000), after the completion of the live event 22902, will be $2000+$400=$2400. Further, the wagering module 22920 may update, at step 23112, the account balance of the user who places the wager in the user database 22910. In this example, after winning the wager of $100 placed (at odds of 4/1), the updated balance of the user i.e. $2400. Thereafter, the process returns, at step 23116, to the base wagering module 22918.

FIG. 232 illustrates the data selection module 22922. The data selection module 22922 may receive, at step 23200, a prompt from the base wagering module 22918. It can be noted that the data selection module 22922 is triggered when the user wants to receive data related to elements involved in the live event 22902. For example, the user wants to receive data (such as batting average, homeruns, runs batted in) related to Aaron Judge (as hitter). The data selection module 22922 may receive, at step 23202, a user selection of the highlighted element. For example, a user selects Aaron Judge of New York Yankees. The element, in this example the player Aaron Judge, selected by the user can be identified in a number of different ways known in the art. One example would be the use of character recognition being applied to the video to identify the numbers on a player's uniform and compare that data to a database of active player numbers. Alternatively, facial recognition could be used in a similar manner to identify players. Further, the data selection module 22922 may retrieve, at step 23204, the available data related to the user selection of the highlighted element. In one embodiment, the data may be retrieved from the historical plays database 22912. In this example, the data selection module 22922 retrieves data related to Aaron Judge (as hitter), such as batting average of 0.273, home runs total 20, runs batted in 67, etc. Further, the data selection module 22922 may display, at step 23206, the available data or menu of available data types. In one embodiment, the data may be displayed on the display of the mobile device 22924. In one example embodiment, data types may correspond to different data sets available i.e. batting data set or pitching data set. It can be noted that the menu option may allow the user for a deeper dive into a type of data. In one embodiment, the data may be displayed in various forms such as drop-down menu, a bar graph, a line graph, pictograph, a histogram, an area graph, or a scatter plot. For example, the available data displayed to the user, corresponds to the previous baseball games played by the Aaron Judge of New York Yankees, batting average of 0.273, home runs total 20, runs batted in 67, etc. Thereafter, the process returns, at step 23208, to the base wagering module 22918.

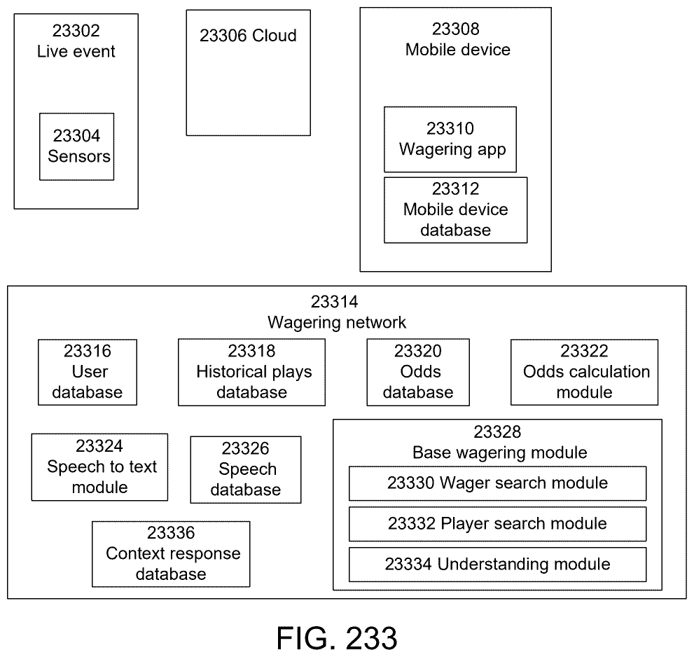

FIG. 233: Illustrates a system for voice-based wagering, according to an embodiment.

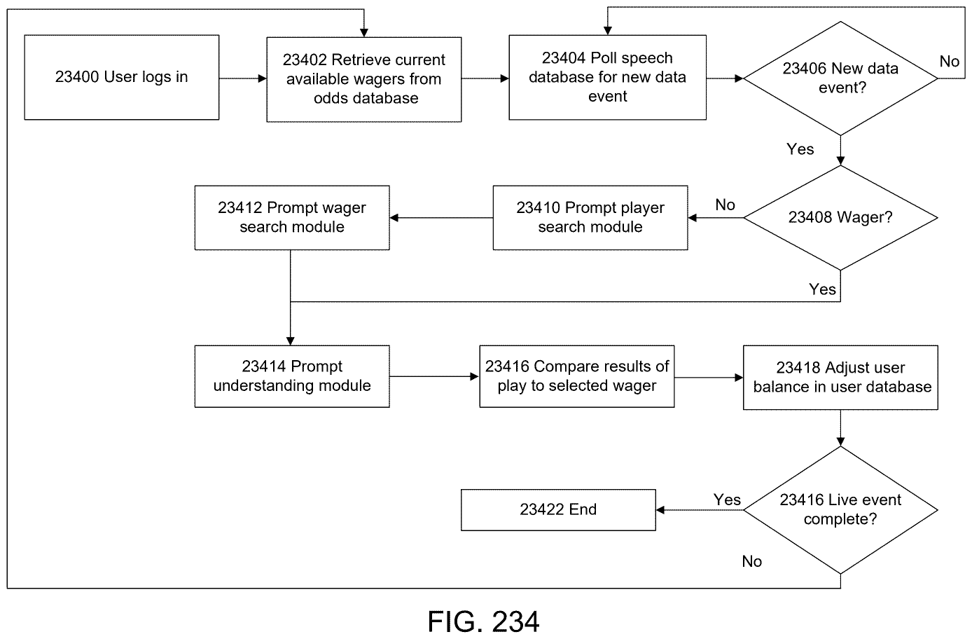

FIG. 234: Illustrates a base wagering module, according to an embodiment.

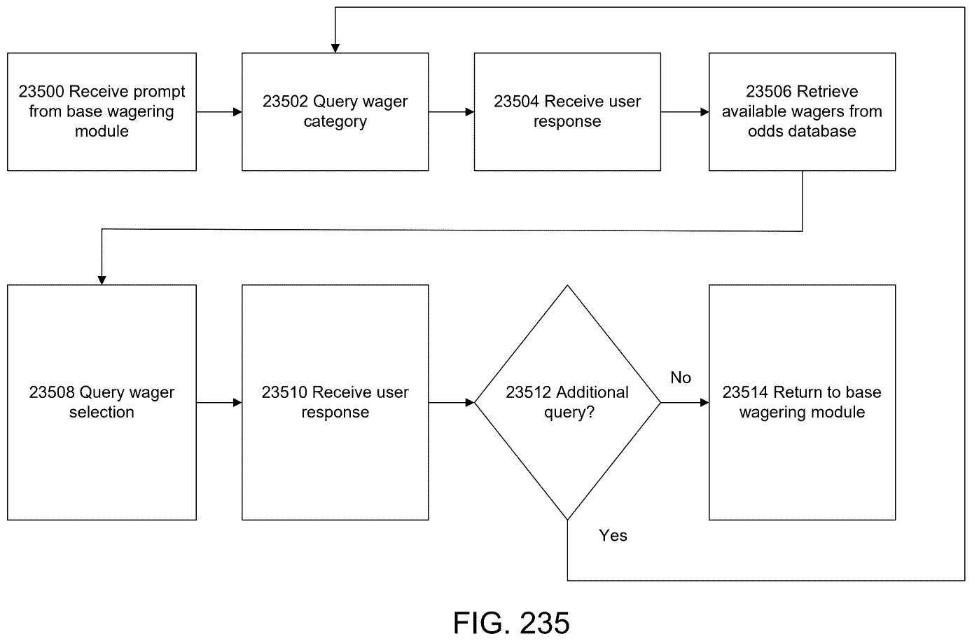

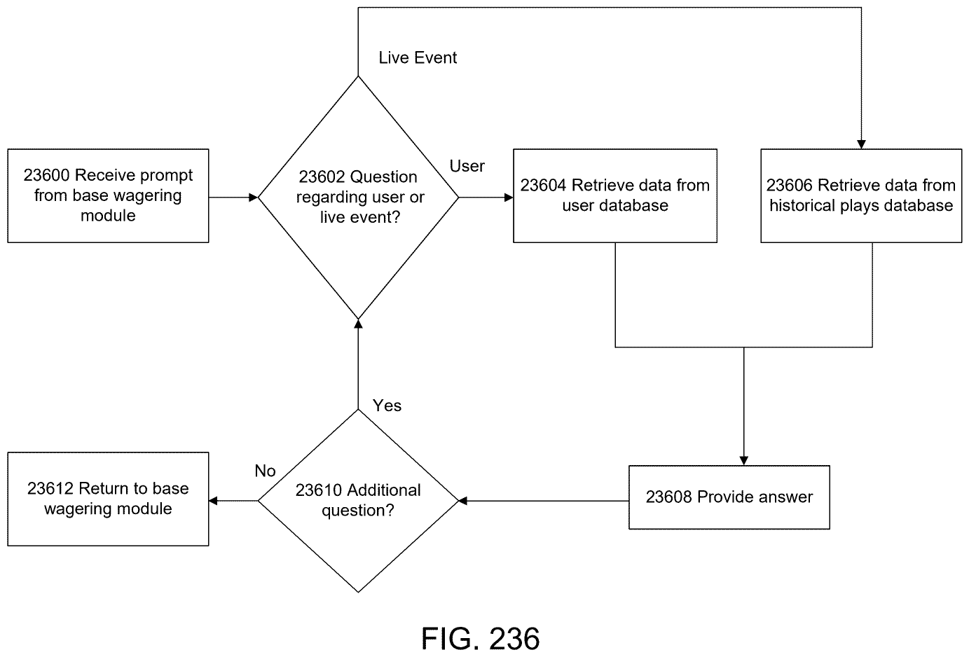

FIG. 235: Illustrates a wager search module, according to an embodiment.

FIG. 236: Illustrates a player search module, according to an embodiment.

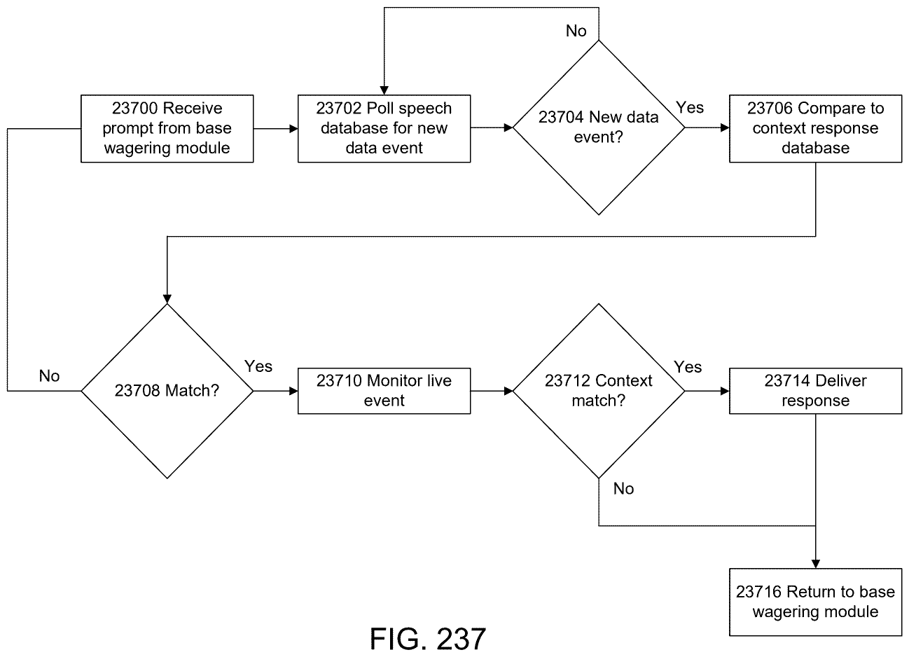

FIG. 237: Illustrates an understanding module, according to an embodiment.

FIG. 233 displays a system for voice-based wagering. This system may include a live event 23302, for example, a sporting event such as a football game, basketball game, baseball game, hockey game, tennis match, golf tournament, eSports or digital game, etc. The live event 23302 will include some number of actions or plays, upon with a user or bettor or customer can place a bet or wager, typically through an entity called a sportsbook. There are numerous types of wagers the bettor can make, including a straight bet, a money line bet, a bet with a point spread or line that the bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk. This is typically applied to round-robin or other tournaments' styles. There are other types of wagers, including parlays, teasers, and prop bets, that are added games that often allow the user to customize their betting by changing the odds and payouts they receive on a wager. Certain sportsbooks will allow the bettor to buy points, to move the point spread off of the opening line. This will increase the price of the bet, sometimes by increasing the juice, vig, or hold that the sportsbook takes. Another type of wager the bettor can make is an over/under, in which the user bets over or under a total for the live event 23302, such as the score of American football or the run line in baseball, or a series of action in the live event 23302. Sportsbooks have several bets they can handle a limit of wagers they can take on either side of a bet before they will move the line or odds off of the opening line.

Additionally, there are circumstances, such as an injury to an important player such as a listed pitcher, in which a sportsbook, casino, or racino will take an available wager off the board. As the line moves, there becomes an opportunity for a bettor to bet on both sides at different points, spreads to middle, and win both bets. Sportsbooks will often offer bets on portions of games, such as first-half bets and half-time bets. Additionally, the sportsbook can offer futures bets on live events 23302 in the future. Sportsbooks need to offer payment processing services in order to cash out customers. This can be done at kiosks at the live event 23302 or at another location.

Further, embodiments may include a plurality of sensors 23304 that may be used such as motion sensors, temperature sensors, humidity sensors, optical sensors and cameras such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices, etc. Also, the plurality of sensors 23304 may include tracking devices, such as RFID tags, GPS chips, or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 23306 or a communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques are known in the art. The communication network may allow ubiquitous access to shared pools of configurable system resources and higher-level services that can be rapidly provisioned with minimal management effort, often over the internet, and relies on sharing of resources to achieve coherence and economics of scale, like a public utility. In contrast, third-party clouds allow organizations to focus on their core businesses instead of expending resources on computer infrastructure and maintenance. Cloud 23306 may be communicatively coupled to peer-to-peer wagering network 23314, which may perform real-time analysis on the type of play and the result of the play. The cloud 23306 may also be synchronized with game situational data, such as the time of the game, the score, location on the field, weather conditions, and the like, which may affect the choice of play utilized. For example, in other exemplary embodiments, the cloud 23306 may not receive data gathered from sensors 23304 and may, instead, receive data from an alternative data feed, such as Sports Radar®. This data may be compiled substantially immediately following the completion of any play, and the data from this feed may be compared with a variety of team data and league data based on a variety of elements, including down, possession, score, time, team, and so forth, as described in various exemplary embodiments herein.

Further, embodiments may include a mobile device 23308 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs by combining some of the inputs and outputs. Some devices allow for facial recognition, which may be utilized as an input for different purposes, including authentication and other commands. Some devices provide for voice recognition and inputs, including, e.g., Microsoft KINECT, SIRI for iPhone by Apple, Google Now, or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality, including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices, or group of devices may be augmented reality devices. An I/O controller may control the I/O devices. The I/O controller may control one or more I/O devices, such as e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g., a USB bus, a SCSI bus, a FireWire bus, an Ethernet bus, a Gigabit Ethernet bus, a Fiber Channel bus, or a Thunderbolt bus. In some embodiments, the mobile device 23308 could be an optional component and would be utilized in a situation where a paired wearable device utilizes the mobile device 23308 as additional memory or computing power or connection to the internet.

Further, embodiments may include a wagering software application or wagering app 23310, which is a program that enables the user to place bets on individual plays in the live event 23302 and display the audio and video from the live event 23302, along with the available wagers on the mobile device 23308. The wagering app 23310 allows the user to interact with the wagering network 23314 to place bets and provide payment/receive funds based on wager outcomes.

Further, embodiments may include a mobile device 23308 database 23316 that may store some or all of the user's data, the live event 23302, or the user's interaction with the wagering network 23314.

Further, embodiments may include a wagering network 23314, which may perform real-time analysis on the type of play and the result of a play or action. The wagering network 23314 (or cloud 23306) may also be synchronized with game situational data, such as the time of the game, the score, location on the field, weather conditions, and the like, which may affect the choice of play utilized. For example, in other exemplary embodiments, a wagering network 23314 may not receive data gathered from sensors 23304 and may, instead, receive data from an alternative data feed, such as SportsRadar®. This data may be provided substantially immediately following the completion of any play, and the data from this feed may be compared with a variety of team data and league data based on a variety of elements, including down, possession, score, time, team, and so forth, as described in various exemplary embodiments herein. The wagering network 23314 can offer several software as a service managed services such as user interface service, risk management service, compliance, pricing and trading service, IT support of the technology platform, business applications, game configuration, state-based integration, fantasy sports connection, integration to allow the joining of social media, as well as marketing support services that can deliver engaging promotions to the user.

Further, embodiments may include a user database 23316, which may contain data relevant to all users of the wagering network 23314, which may include, a user ID, a device identifier, a paired device identifier, wagering history, and wallet information for the user. The user database 23316 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 23316 may contain betting lines and search queries. The user database 23316 may be searched based on a search criterion received from the user. Each betting line may include a plurality of betting attributes such as at least one of the live event 23302, a team, a player, an amount of wager, etc. The user database 23316 may include information related to all the users involved in the live event 23302. In one example embodiment, the user database 23316 may include information for generating a user authenticity report and a wagering verification report. Further, the user database 23316 may be used to store user statistics like, but not limited to, the retention period for a particular user, frequency of wagers placed by a particular user, the average amount of wager placed by each user.

Further, embodiments may include a historical play database 23318 that may contain play data for the type of sport being played in a live event 23302. For example, in American Football, for optimal odds calculation, the historical play data should include metadata about the historical plays, such as time, location, weather, previous plays, opponent, physiological data, etc.

Further, embodiments may utilize an odds database 23320 that contains the odds calculated by the odds calculation module 23322 to display the odds on the user's mobile device 23308 and to take bets from the user through the mobile device 23308 wagering app 23310.

Further, embodiments may include an odds calculation module 23322, which utilizes historical play data to calculate odds for in-play wagers.

Further, embodiments may include a speech to text module 23324, which takes the speech captured by the user's mobile device 23308, as well as the context of the wagering app 23310 and converts the speech to text and stores the text data as well as the context data on the speech database 23326.

Further, embodiments may include a speech database 23326, which stores the data for the text from speech, timestamps of this text, the status of the wagering app 23310, and the context of the live event 23302 at the time the speech is received, etc.

Further, embodiments may include a base wagering module 23328, which may allow the user to place wagers on the live event 23302. The base wagering module 23328 may have several functions, including base choice functionality, in which any button icon on the app “Bet on Pass,” “Bet on Run” can be voiced in, and when that voice is translated, the button voiced in will flash to let the user know the player was “heard” and the user can voice in “OK” to approve. Numerical capability, in which the system could ask a question to the user such as “how much would you like to bet?” and then start blinking, waiting for voice response. The player may say “eleven dollars,” the wagering app 23310 hears the voice, and speech to text module 23324 translates the voice to “11 dollars” on the screen region for the bet blinking, waiting for the player to say “OK” or otherwise confirming the entry or placement of a wager. The base wagering module 23328 may prompt the wager search module 23330 to allow the user to find the desired wager. The base wagering module 23328 may prompt the user search module 23332 (also called a player search module 23332) to allow the user to search for statistics related to the live event 23302, the players, or their wagering history. The base wagering module 23328 may prompt the understanding module 23334 to listen to the user for context related to their current wager to provide a personalized and context-appropriate response. The base wagering module 23328 may retrieve available wagers for the selected element. In one embodiment, the base wagering module 23328 may retrieve available wagers from the odds database 23320. In this example, the base wagering module 23328 retrieves available wagers for Aaron Judge (as a hitter), i.e., odds on Aaron Judge hitting a single are odds 4/1, and the odds of him hitting a home run are 5/1. Further, the base wagering module 23328 may display a menu of available wagers related to the selected. In one embodiment, the menu may be displayed via the wagering app 23310 on the display of the mobile device 23308. Further, the base wagering module 23328 may receive a wager from the user. For example, the user places a wager of $100 on Aaron Judge, hitting a single at odds 4/1. Further, base wagering module 23328 may constantly monitor the live event 23302 for completion of a given play. In one case, when the wagered upon play is concluded, then base wagering module 23328 may proceed to obtain the results of the live event 23302. For example, the result of the live event 23302 is that Aaron Judge hits a single during the live event 23302. In another case, when the live event 23302 is not concluded, then the base wagering module 23328 may continue monitoring the live event 23302 for completion. Further, the base wagering module 23328 may compare the result of the live event 23302 with the user's wagers to determine a result, i.e., whether the user has won or lost. In this example, the wager of $100 placed for Aaron Judge hitting a single and the result of the live event 23302, i.e., Aaron Judge hits a single, are compared to determine the result of the wager, i.e., a win for the user. Based on the comparison of the result of the live event 23302 and the wagers placed by the user, the base wagering module 23328 may calculate the balance amount for the user. For example, the user wins the wager of $100 at +400 odds that Aaron Judge will hit a single on the next play and the result of the live event 23302 is Aaron Judge hits a single. Thus, the updated balance of the user (with an opening balance of $2000), after the completion of the live event 23302, will be $2000+$400=$2400. Further, the base wagering module 23328 may update the account balance of the user who places the wager. In this example, after winning the wager of $100 placed (at odds of 4/1), the updated balance of the user, i.e., $2400.

Further, embodiments may include a wager search module 23330, which may allow the user to find the desired wager. The wager search module 23330 could ask a question or type a question on the user mobile device 23308 “what type of current player to bet on,” the system listening for the user to say “pitcher” or “batter” or “centerfielder,” or “jersey number 12”. Once the voice is heard and translated, the selection blinks, for example, “batter,” and then the app listens for an “OK,” once heard, the “in play” bet for the “batter” is shown.

Further, embodiments may include a player or user search module 23332, which may allow the user to ask generic search question” for historical information, such as the player invokes a “tell me” command. Then a search is done of the historical plays database 23318 for the player the bet is about, such as “tell me the batters RBI's in the last year” and those statistics may be retrieved from the historical plays database 23318. The player or user search module 23332 may use the player's voice commands to show account information or to set alerts or settings. For instance, a player invokes a “show me” command, such as “show me how much I won” or “show me how much I have bet” or “show me my history of success on the current play” and the voice question is analyzed based upon the wagering app 23310 data and wagering app 23310 context (the current play).

Further, embodiments may include an understanding module 23334, which may record the player's voice either before, during, or after the play. The understanding module 23334 may relate the text from speech based upon this time, and the text is interpreted by AI to determine if there is an AI-based response for reaction, so for instance, the in-play was for a large bet on a run coming home, the payer bet on a run coming in when the bet was placed, the voice was activated to annotate a response, such as “I really want this run now, we need this run to get to the pennant,” after the play and after the run is in, the AI has stocked positive answers since the play was one, and since the voice had pennant, the AI comes back and says, “congratulations bob, looks like you will get to the pennant race” or if the bet was a loss, no run, the AI comes back with stock, “so sorry Bob, maybe there will be another chance to get to the pennant” (if that is possible thru calculations).

Further, embodiments may include a context response database 23336, which may contain key words and phrases that the understanding module 23334 may identify, and potential responses to deliver based on the context of the play/wager and the key words or phrases.

FIG. 234 displays the base wagering module 23328. The process begins with the user logging in at step 23400 to the wagering app 23310. Available wagers on the live event 23302 may then be retrieved at step 23402 from the odds database 23320. The speech database 23326 may be polled at step 23404 for a new data event. A new data event may be any speech converted to text by the speech to text module 23324. The speech to text module 23324 may be active whenever the user is connected to the wagering app 23310. The speech to text module 23324 may be trained to recognize the user's voice to allow the speech to text module 23324 to filter out speech from other users. This recognition may allow users to interact with the system while in a noisy environment without the background speech interfering. In one embodiment, the speech to text module 23324 may only process speech when the user may be identified by a sensor on the mobile device 23308 to avoid processing background speech. For example, the speech to text module 23324 may only process speech when a facial recognition system on the mobile device 23308 detects the user, or a wearable device such as augmented reality glasses may have a microphone that is located near enough to the user to separate speech that comes from the user from background speech. The speech database 23326 may continue to be polled until a new data event is identified at step 23406. It may then be determined at step 23408 if the new data event is related to a wager. For example, the user may say “Bet on Pass” or “Bet on Run” In one embodiment, the mobile device 23308 display may flash to indicate to the user that they were heard, and the user may voice “OK” to approve the wager. If the new data event is a “tell me” or “show me” command, the user or player search module 23332 may be prompted at step 23410. For example, the user may say, “how has Aaron Judge done against Clayton Kershaw in the past.” The user or player search module 23332 may retrieve that data from the historical plays database 23318. If the new data event is related to a wager, the wager search module 23330 may be prompted at step 23412. For example, the user may say, “show me all wagers on the batter.” The wager search module 23330 may query the odds database 23320 for wagers available on the current batter in the live event 23302. In one embodiment, the wager search module 23330 may begin without a prompt. For example, if no new data event is identified in the speech database 23326, the wager search module 23330 may be prompted to ask, “what type of current player do you wish to bet on?” or “do you want to bet on a run?” Once the user has selected a wager, the understanding module 23334 may be prompted at step 23414. The understanding module 23334 may monitor the speech database 23326 during the wagered upon play to deliver a personalized and context-appropriate response to the user. This may be to increase their enjoyment or engagement with the wagering app 23310. The results of the current play in the live event 23302 may be compared, at step 23416, to the wagered upon outcome. The user's account balance in the user database 23316 may be adjusted at step 23418 based on the results of the wagered upon play. In one embodiment, the settlement of wagers and/or managing of accounts may be handled by a third-party financial services provider. It may then be determined, at step 23420, if the live event 23302 is complete? If the live event 23302 is not complete, the process returns to step 23402. If the live event 23302 has concluded, or the user has logged off of the wagering app 23310, the process ends at step 23422.

FIG. 235 displays the wager search module 23330. The process begins with receiving a prompt from the base wagering module 23328. The wager category the user may be interested in may then be queried at step 23502. For example, the user may be asked, “what type of player do you want to bet on?” or “do you want to bet on a pass?” The user's response may be received at step 23504. For example, the user may say “pitcher” or “batter” or “centerfielder” or “jersey number 12” The wagers available for the selected wager category may be retrieved at step 23506 from the odds database 23320. For example, if the user says “batter,” the current player at-bat in the live event 23302 may be identified, and the wagers related to them, such as a 3/1 on a hit and 4/1 on a strikeout. The wager selection the user may be interested in may then be queried at step 23508. For example, the system may say, or display on the user's mobile device 23308, “how much would you like to wager?” or “do you want to bet on run or pass?” or “will Aaron Judge strikeout?” The user's response may be received at step 23510. It may then be determined at step 23512 if there is an additional query. For example, if the user were asked at step 23508, “how much would you like to bet?” and then start blinking, waiting for a voice response. The player may say “eleven dollars,” the speech-to-text module 23324 may hear the voice and translates the voice to “11 dollars” on the screen region for the bet blinking, waiting for the player to say “OK.” The user may also indicate they wish to look at other available wagers, such as a wager on the pitcher, and the process may return to step 23502 if there are no additional queries the process returns, at step 23514 to the base wagering module 23328.

FIG. 236 displays the user or search module 23332. The process begins with receiving, at step 23600, a prompt from the base wagering module 23328 indicating the user asked a question that may be related to the user or the live event 23302. It should be obvious to one skilled in the art that the functions of the user or player search module 23332, the wager search module 23330 may have some or all of their functions combined. It may be determined at step 23602 if the question is related to the user or the live event 23302. For example, the user may ask a generic search question for historical information, such as when the user invokes a “tell me” command, such as “tell me the batters RBI's in the last year.” The user may ask to be shown account information or to set alerts or settings. For example, a user invokes a “show me” command, such as “show me how much I won” or “show me how much I have bet” or “show me my history of success on the current play.” If the question is about the user, the user database 23316 may be queried at step 23604. For example, if the user asked, “show me how much I have bet,” the user's wager history may be retrieved. If the question is about the live event 23302, the historical plays database 23318 may be queried at step 23606. For example, if the user asked, “tell me the batter's RBI's in the last year,” the current batter's statistics for the previous season may be retrieved. The answer to the user's question may be provided at step 23608. In one embodiment, the response may be delivered by voice. It may also be displayed on the mobile device 23308. In one embodiment, the mobile device 23308 may be a remote control for a smart television. In that example, the response may be displayed on the television. It may then be determined at step 23610 if the user has additional questions. If the user has additional questions, the process returns to step 23602. If the user does not have any more questions, the process returns at step 23612 to the base wagering module 23328.

FIG. 237 displays the understanding of module 23334. The process begins with receiving at step 23700, a prompt from the base wagering module 23328 indicating that the user has placed a wager on at least one outcome of the current play in the live event 23302. The understanding module 23334 may then poll at step 23702, the speech database 23326, for a new data event. A new data event may be user speech that may be converted to text by the speech to text module 23324. It may be determined at step 23704 if there is a new data event in the speech database 23326. If there is no new data event detected, the process returns to step 23702. The understanding module 23334 may continue to poll the speech database 23326 for a new data event until the current play that has been wagered upon has concluded. If a new data event is detected, the understanding module 23334 may compare, at step 23706, the text of the new data event to the context response database 23336. For example, the user placed a large wager on a run coming home, and the speech-to-text module 23324 identified the user saying, “I really want this run now. We need this run to get to the pennant.” The context response database 23336 may indicate the word pennant is relevant. The context response database 23336 may indicate, at step 23708, a match to the words run and pennant. If no match is identified at step 23708, the process may return to step 23702 and poll for new speech to text data events until the play is concluded. If there is a match identified at step 23708, the live event 23302 may be monitored at step 23710. It may be determined, at step 23712, if there is a context characteristic of the live event 23302 that matches a possible response in the context response database 23336. For example, the word pennant may prompt a query of the historical plays database 23318 for the current league standings and identify that the team the user wagered upon, in this case, the New York Yankees, are in first place in the league and could clinch the American League pennant with a win in the current live event 23302. The wagered upon run would put the New York Yankees ahead in the game. The context response database 23336 may have a number of potential responses based on the live event's 23302 different context characteristics, the wager, and the user. For example, if the run scores on the current play, the context response database 23336 may indicate a response of “Congratulations (insert user name), your (wagered upon team name) are one step closer to winning the pennant.” The indicated response if the run does not score, and there is an opportunity to still score the run, may be “Don't worry (insert user name), (insert next batter's name) can still get this run home.” There may not be an indicated response in the context response database 23336 if the run does not score and there is not an immediate opportunity to score the run. Responses may be designed to be positive to keep the user in a good mood so that they remain engaged in wagering upon the live event 23302. In one embodiment, the responses may be based on the context of the wager. For example, a user may be heard to say, “If I win this, we can get that new car.” Artificial intelligence may identify the name of a consumer product, such as a car, or TV, or pair of shoes, within two words of the word “new” and determine that the user may be talking about what they may do with the money if they win the current wager. If the user wins their wager, the context response database 23336 may indicate a response of “Congratulations (insert user name), now you can get that car!” In one embodiment, user spending history may be compared to speech captured during certain wagering contexts through linear regression to identify words, phrases, or other text combinations that have a correlation coefficient above a pre-defined threshold with certain spending behavior. In one embodiment, trends in user wagering history may be convolved with the volume to speech captured during certain wagering contexts to identify excitement levels that may be highly correlated with certain wagering activity. For example, a user has a steadily rising volume level through the play and a sustained high volume level for 5 seconds after the play concluded. When it coincides with a wager the user won, this pattern may be highly correlated with the user making a follow-up bet. The system may then say, “Great win (user), want to go double or nothing on (insert wager option).” If a match is identified at step 23712, the response indicated in the context response database 23336 may be delivered to the user. This may be audibly or via text on the display of the user's mobile device 23308 or other secondary display. The process then returns, at step 23716, to the base wagering module 23328.

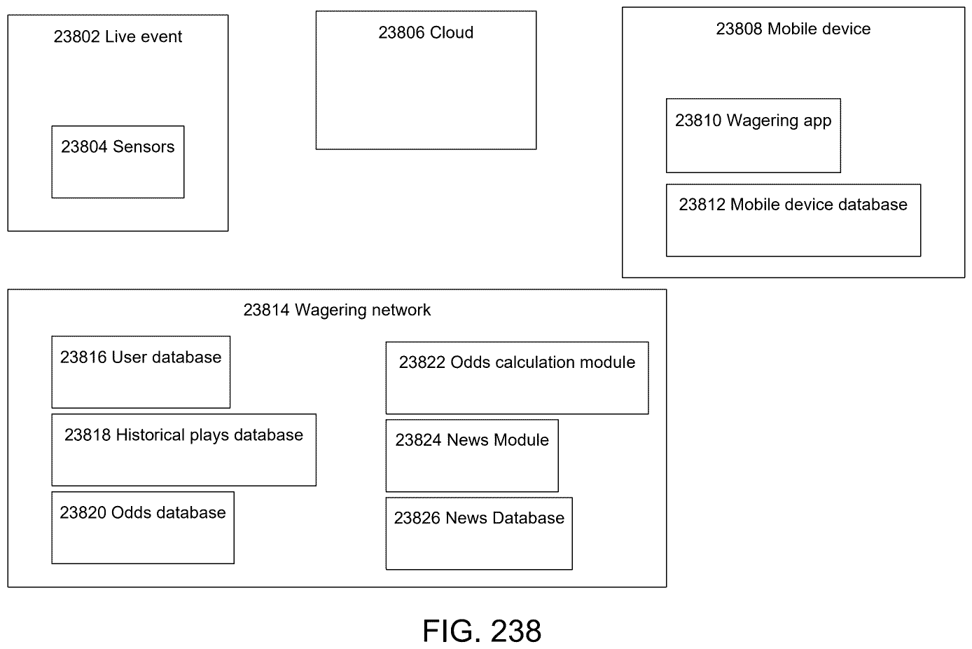

FIG. 238: illustrates a system for displaying news related to a wager, according to an embodiment.

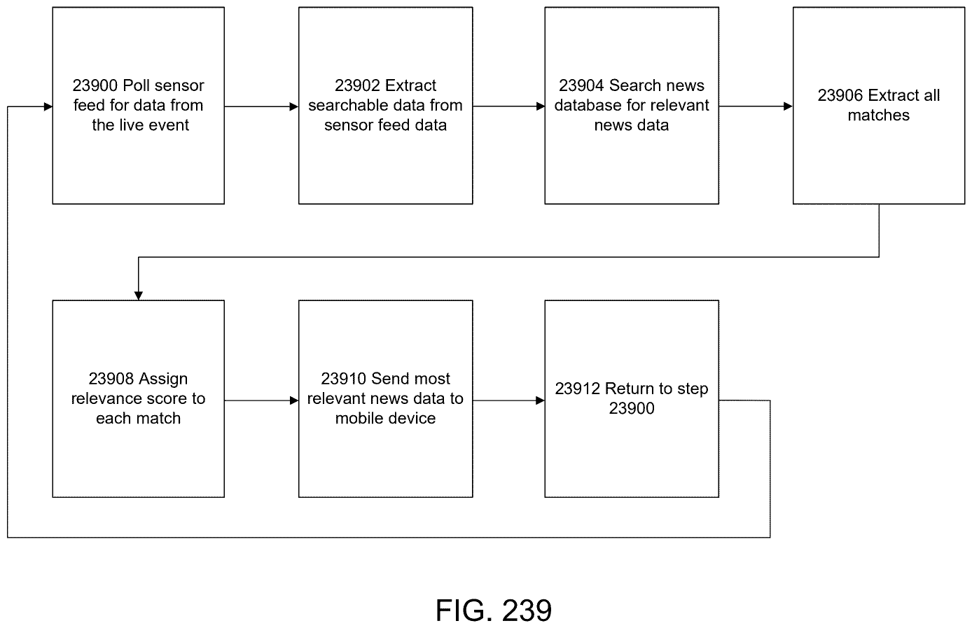

FIG. 239: illustrates a news module, according to an embodiment.

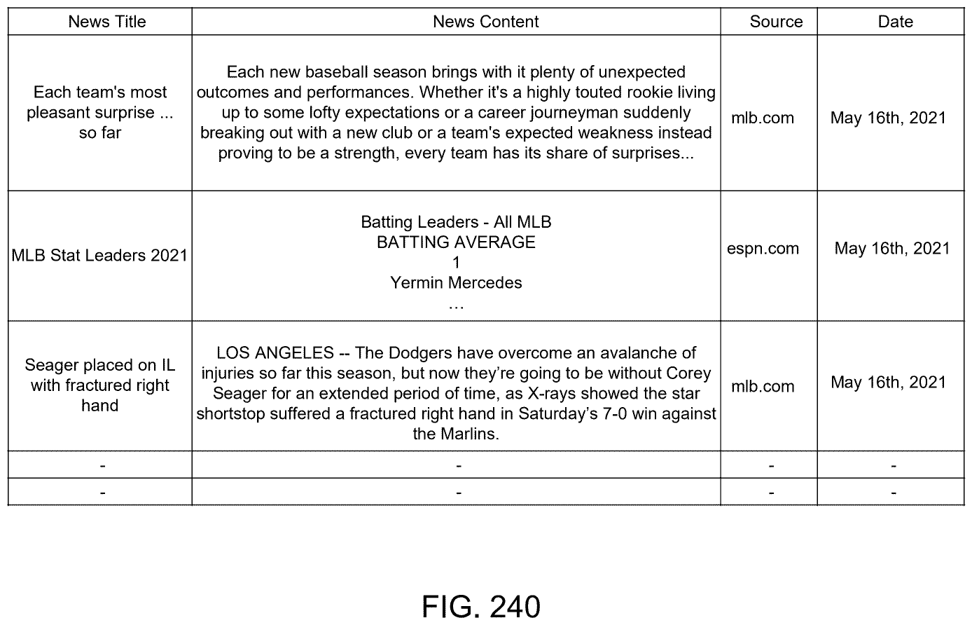

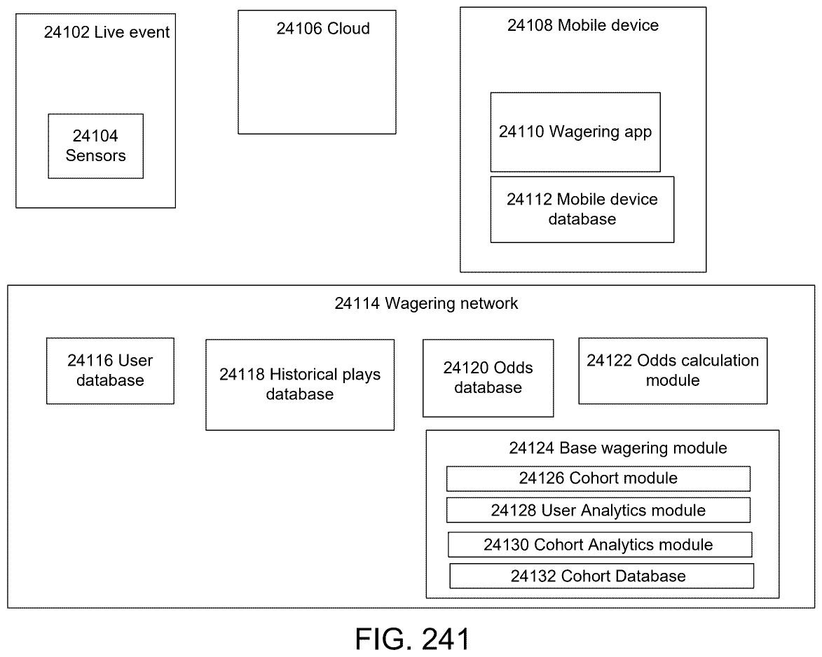

FIG. 240: illustrates a news database, according to an embodiment.

FIG. 238 displays a system for displaying news related to a wager. This system may include a live event 23802, for example, a sporting event such as a football, basketball, baseball, or hockey game, tennis match, golf tournament, eSports, or digital game, etc. The live event 23802 may include some number of actions or plays upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 23802, such as the score of an American football game or the run line in a baseball game, or a series of actions in the live event 23802. Sportsbooks have several bets they can handle, limiting the number of wagers they can take on cither side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live event 23802 in the future. Sportsbooks need to offer payment processing services to cash out customers, which can be done at kiosks at the live event 23802 or at another location.

Further, embodiments may include a plurality of sensors 23804 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 23804 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 23806 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art.

The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 23806 may be communicatively coupled to a peer-to-peer wagering network 23814, which may perform real-time analysis on the type of play and the result of the play. The cloud 23806 may also be synchronized with game situational data such as the time of the game, the score, location on the field, weather conditions, and the like, which may affect the choice of play utilized. For example, in an exemplary embodiment, the cloud 23806 may not receive data gathered from the sensors 23804 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 23808 such as a computing device, laptop, smartphone, tablet, computer, smart speaker, or I/O devices. I/O devices may be present in the computing device. Input devices may include but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, Fire Wire, Ethernet, Gigabit Ethernet, Fiber Channel, or Thunderbolt buses. In some embodiments, the mobile device 23808 could be an optional component and would be utilized in a situation where a paired wearable device employs the mobile device 23808 for additional memory or computing power or connection to the internet.

Further, embodiments may include a wagering software application or a wagering app 23810, which is a program that enables the user to place bets on individual plays in the live event 23802, streams audio and video from the live event 23802, and features the available wagers from the live event 23802 on the mobile device 23808. The wagering app 23810 allows the user to interact with the wagering network 23814 to place bets and provide payment/receive funds based on wager outcomes.

Further, embodiments may include a mobile device database 23812 that may store some or all the user's data, the live event 23802, or the user's interaction with the wagering network 23814.

Further, embodiments may include the wagering network 23814, which may perform real-time analysis on the type of play and the result of a play or action. The wagering network 23814 (or the cloud 23806) may also be synchronized with game situational data, such as the time of the game, the score, location on the field, weather conditions, and the like, which may affect the choice of play utilized. For example, in an exemplary embodiment, the wagering network 23814 may not receive data gathered from the sensors 23804 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 23814 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 23816, which may contain data relevant to all users of the wagering network 23814 and may include, but is not limited to, a user ID, a device identifier, a paired device identifier, wagering history, or wallet information for the user. The user database 23816 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 23816 may contain betting lines and search queries. The user database 23816 may be searched based on a search criterion received from the user. Each betting line may include, but is not limited to, a plurality of betting attributes such as at least one of the live event 23802, a team, a player, an amount of wager, etc. The user database 23816 may include but is not limited to information related to all the users involved in the live event 23802. In one exemplary embodiment, the user database 23816 may include information for generating a user authenticity report and a wagering verification report. Further, the user database 23816 may be used to store user statistics like, but not limited to, the retention period for a particular user, frequency of wagers placed by a particular user, the average amount of wager placed by each user, etc.

Further, embodiments may include a historical plays database 23818 that may contain play data for the type of sport being played in the live event 23802. For example, in American Football, for optimal odds calculation, the historical play data may include metadata about the historical plays, such as time, location, weather, previous plays, opponent, physiological data, etc. Further, embodiments may utilize an odds database 23820—that contains the odds calculated by an odds calculation module 23822—to display the odds on the user's mobile device 23808 and take bets from the user through the mobile device wagering app 23810.

Further, embodiments may include the odds calculation module 23822, which utilizes historical play data to calculate odds for in-play wagers.

Further, embodiments may include a news module 23824, which may collect data from the sensors 23804 of the live event 23802 and search for relevant news data in the news database 23826. The news data may then be sent to the mobile device 23808 to be displayed by the wagering app 23810. Relevant news data may be determined by finding information in the news data related to certain aspects of the live event 23802, such as teams, players, location, weather, etc.

Further, embodiments may include a news database 23826 which may contain news data related to the live event 23802. News data may include, but is not limited to, news articles, stats, reports, opinions, live commentary, etc. The data may contain meta tags to assist in searching. News data related to the live event 23802 may be news about the live event 23802, the teams, players, similar teams or players, similar events, weather, etc.

FIG. 239 displays the news module 23824. The process may begin with the news module 23824 polling, at step 23900, for data from the live event 23802 via the sensors 23804. This polling may occur continuously or at designated periods, such as the end of a play, the close of a previous wager in a wagering system, or the offering of a new wager in a wagering system. The news module 23824 may extract, at step 23902, searchable data from the sensors 23804. Searchable data may be any data that may assist in finding relevant news data. For example, the current active players in the live event 23802 and/or their position on the field. In contrast, data such as depth of field, latency, game clock time, and/or noise level, may be present in the sensors 23804, but is unlikely to lead to relevant news data and therefore, may not be considered as searchable data. An administrator or another module may determine which data is considered searchable data. The news module 23824 may search, at step 23904, the news database 23826 for news data relevant to the extracted searchable data. For example, if the live event 23802 is a baseball game with the Giants playing the Reds and the Giants are at-bat with two outs in the top of the second inning, the news module 23824 may search news database 23826 for “Giants,” “Reds,” “Second Inning,” and/or “Two Outs” in the text of the news data content. The news module 23824 may also search for these terms in the metadata or tags of the news data if available. This search may return, for example, articles concerning either team, prior games between them, recent stats for the teams, articles regarding strategies for the early innings of baseball, commentary on player stress when there are two outs, etc.

The news module 23824 may include tags or terms in the search related to an available wager. For example, if a current wager has options such as a walk, single, out, or home run, these may be added to the search terms. The news module 23824 may filter results based on the source of the news data. For example, if a user indicated they prefer news from mlb.com, then the search may only return news data from that source. The news module 23824 may add additional search criteria not obtained from the sensors 23804, such as other teams in the same league that are contending to rank with the current teams. The news module 23824 may add default terms to the search criteria to find news data that may impact the play. For example, the news module 23824 may add “weather forecast” to the list of terms to find news data on the expected weather. The news module 23824 may extract, at step 23906, all matches found in the news database 23826. The news module 23824 may assign, at step 23908, a relevance score to each match. The relevance score may depend on the number of search tags or terms that appeared in the content of the news data. For example, a news article that included both “Giants” and “Reds” may have a higher relevance score than one that only included “Giants.” Some terms may be weighted higher than others; for example, terms associated with a currently available wager such as “home run” may have a higher relevance score than “Giants.” These weights may be set by an administrator or by a module that may use a learning algorithm. The news module 23824 may also use natural language processing to determine if the search tags or terms in the news data are relevant. For example, a news article that contains search tags or terms used out of context may receive a lower relevance score than an article where the search tags or terms are the main subjects. The news module 23824 may send, at step 23910, the matching news data with the highest relevance score to the mobile device 23808. The news module 23824 may send multiple news data results, for example, the top five most relevant. The mobile device 23808 may display the news data via the wagering app 23810. If multiple news data results are sent, the mobile device 23808 may display them all at once, rotate through the results, choose a result randomly, etc. The news module 23824 may return, at step 23912, to step 23900.

FIG. 240 displays the news database 23826. The news database 23826 may contain news data related to the participants in the live event 23802, which may assist users who are deciding how to wager. The news database 23826 may contain news articles relevant to the live event 23802, the teams, players, similar teams or players, similar events, weather, or any other factor that may inform the user how best to place their wager. The news database 23826 may contain titles and content for each entry, a source where the news data was obtained, and/or a date. In one embodiment, the news database 23826 may contain sensor data from which relevant information may be extracted. For example, video data may be examined to determine that a player is wincing or limping. The data may then be reported to a user as a “potential injury,” after being processed through optical recognition.

FIG. 241: illustrates a method for performing analytics on a user's wagering history, according to an embodiment.

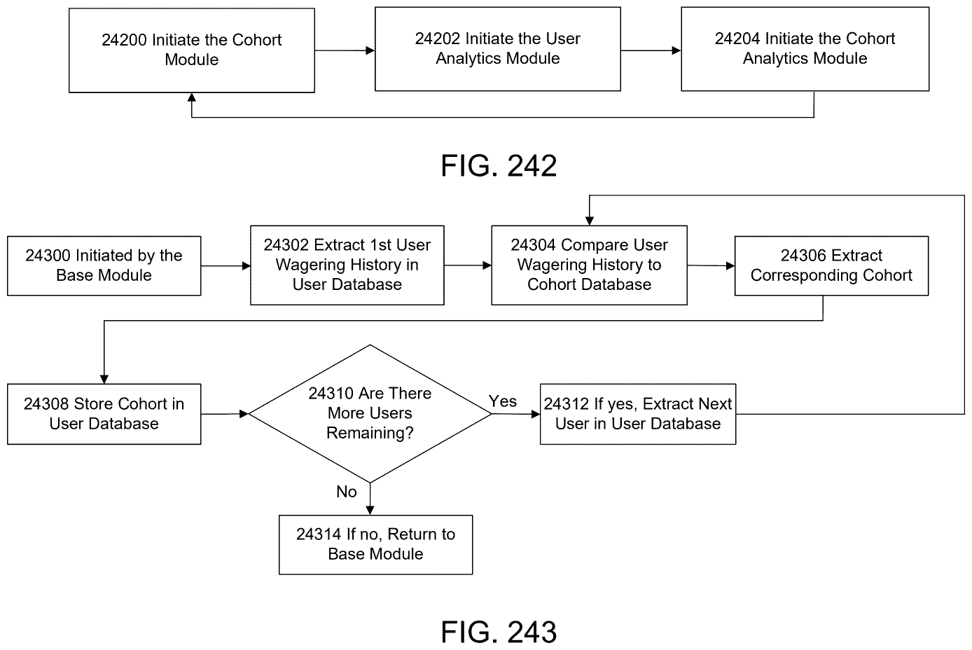

FIG. 242: illustrates a base module, according to an embodiment.

FIG. 243: illustrates a cohort module, according to an embodiment.

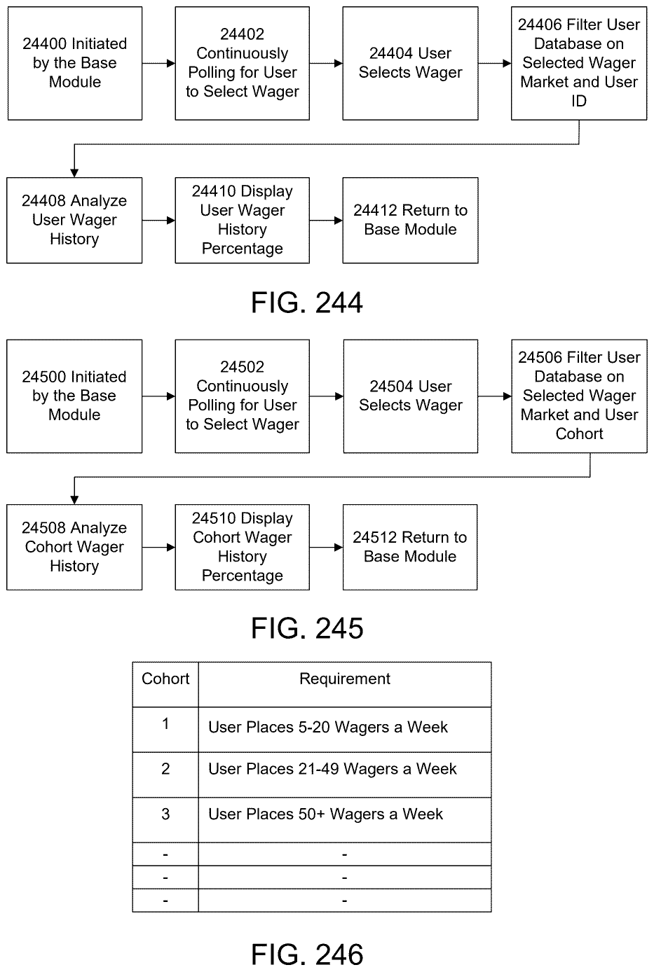

FIG. 244: illustrates a user analytics module, according to an embodiment.

FIG. 245: illustrates a cohort analytics module, according to an embodiment.

FIG. 246: illustrates a cohort database, according to an embodiment.

FIG. 241 displays a method for performing analytics on a user's wagering history. This system may include a live event 24102, for example, a sporting event such as a football, basketball, baseball, or hockey game, tennis match, golf tournament, eSports, or digital game, etc. The live event 24102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 24102, such as the score of an American football game or the run line in a baseball game, or a series of actions in the live event 24102. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live event 24102 in the future. Sportsbooks need to offer payment processing services to cash out customers which can be done at kiosks at the live event 24102 or at another location.

Further, embodiments may include a plurality of sensors 24104 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 24104 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 24106 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 24106 may be communicatively coupled to a peer-to-peer wagering network 24114, which may perform real-time analysis on the type of play and the result of the play. The cloud 24106 may also be synchronized with game situational data such as the time of the game, the score, location on the field, weather conditions, and the like, which may affect the choice of play utilized. For example, in an exemplary embodiment, the cloud 24106 may not receive data gathered from the sensors 24104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 24108 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or

Thunderbolt buses. In some embodiments, the mobile device 24108 could be an optional component and would be utilized in a situation where a paired wearable device employs the mobile device 24108 for additional memory or computing power or connection to the internet.

Further, embodiments may include a wagering software application or a wagering app 24110, which is a program that enables the user to place bets on individual plays in the live event 24102, streams audio and video from the live event 24102, and features the available wagers from the live event 24102 on the mobile device 24108. The wagering app 24110 allows the user to interact with the wagering network 24114 to place bets and provide payment/receive funds based on wager outcomes.

Further, embodiments may include a mobile device database 24112 that may store some or all the user's data, the live event 24102, or the user's interaction with the wagering network 24114.

Further, embodiments may include the wagering network 24114, which may perform real-time analysis on the type of play and the result of a play or action. The wagering network 24114 (or the cloud 24106) may also be synchronized with game situational data, such as the time of the game, the score, location on the field, weather conditions, and the like, which may affect the choice of play utilized. For example, in an exemplary embodiment, the wagering network 24114 may not receive data gathered from the sensors 24104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 24114 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 24116, which may contain data relevant to all users of the wagering network 24114 and may include, but is not limited to, a user ID, a device identifier, a paired device identifier, wagering history, or wallet information for the user. The user database 24116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 24116 may contain betting lines and search queries. The user database 24116 may be searched based on a search criterion received from the user. Each betting line may include but is not limited to, a plurality of betting attributes such as at least one of the following: the live event 24102, a team, a player, an amount of wager, etc. The user database 24116 may include, but is not limited to, information related to all the users involved in the live event 24102. In one exemplary embodiment, the user database 24116 may include information for generating a user authenticity report and a wagering verification report. Further, the user database 24116 may be used to store user statistics like, but not limited to, the retention period for a particular user, frequency of wagers placed by a particular user, the average amount of wager placed by each user, etc.

Further, embodiments may include a historical plays database 24118 that may contain play data for the type of sport being played in the live event 24102. For example, in American Football, for optimal odds calculation, the historical play data may include metadata about the historical plays, such as time, location, weather, previous plays, opponent, physiological data, etc.

Further, embodiments may utilize an odds database 24120—that may contain the odds calculated by an odds calculation module 24122—to display the odds on the user's mobile device 24108 and take bets from the user through the mobile device 24108 wagering app 24110.

Further, embodiments may include the odds calculation module 24122, which may utilize historical play data to calculate odds for in-play wagers.

Further, embodiments may include a base module 24124, which initiates the cohort module 24126, the user analytics module 24128, and the cohort analytics module 24130.

Further, embodiments may include a cohort module 24126, which may extract the first user wagering history in the user database 24116. For example, the user database 24116 may contain the user ID, a device identifier, a paired device identifier, wagering history, or wallet information for the user. Then the cohort module 24126 may compare the extracted user wager history to the cohort database 24132. For example, if the user places ten wagers per week, the user may be placed in cohort one since the requirement for cohort one is that the user places between five and twenty wagers a week. Another example may be if the user places 30 wagers a week, then the user may be placed in cohort two since the requirement for cohort two is that the user places between 21 and 49 wagers per week. In some embodiments, the cohorts may be determined by the number wagers of placed by a user, the amount of money wagered by the user, the amount of time spent on the wagering application or wagering platform, the number of friends the user has on the wagering application or wagering platform, the amount of research the user performs on the wagering application or wagering platform, or any combination thereof. The cohort module 24126 may extract the corresponding cohort. For example, the cohort module 24126 may extract the cohort number, such as 1, from the cohort database 24132. Then the cohort module 24126 may store the extracted cohort in the user database 24116. For example, the cohort module 24126 may store cohort 1 in the user database 24116. The cohort module 24126 may determine if more users are remaining in the user database 24116. For example, the cohort module 24126 may go through each user in the user database 24116 to give a cohort for each user. If there are more users in the user database 24116, then the cohort module 24126 may extract the next user's wagering history in the user database 24116, and the process may return to comparing the wagering history to the cohort database 24132. If there are no more users remaining in the user database 24116, then the cohort module 24126 may return to the base module 24124.

Further, embodiments may include a user analytics module 24128, which may continuously poll for the user to select a wager, and then the user may select a wager. The user analytics module 24128 may filter the user database 24116 for the selected wager market and the user ID. Then the user analytics module 24128 may analyze the user's wager history from the filtered user database 24116 and display the user's wager history percentage on the wagering app 24110. Then the user analytics module 24128 may return to the base module 24124.

Further, embodiments may include a cohort analytics module 24130 that may continuously poll for the user to select a wager, and then the user may select a wager. The cohort analytics module 24130 may filter the user database 24116 for the selected wager market and the user cohort, and then the cohort analytics module 24130 may analyze the cohort's wager history from the filtered user database 24116. The cohort analytics module 24130 may display the cohort's wager history percentage on the wagering app 24110, and the cohort analytics module 24130 may return to the base module 24124.

Further, embodiments may include a cohort database 24132, which may contain the cohort, such as 1, 2, 3, etc. and the requirement for the user to be placed in that cohort, such as the user places 5-20 wagers a week; the user places 21-49 wagers a week, the user places 50 or more wagers a week. The cohort database 24132 may be used in the process described in the cohort module 24126 to place users in cohorts that represent their skill level for the wagering app 24110. In some embodiments, the cohort database 24132 requirements may use historical wagering patterns over a day, week, month, year, etc. In some embodiments, the cohort database 24132 requirements may be based on a monetary value, such as the more money spent by a user, the higher the cohort. In some embodiments, the cohorts may be determined by the number wagers of placed by a user, the amount of money wagered by the user, the amount of time spent on the wagering application or wagering platform, the number of friends the user has on the wagering application or wagering platform, the amount of research the user performs on the wagering application or wagering platform, or any combination thereof.

FIG. 242 displays the base module 24124. The process may begin with the base module 24124 initiating, at step 24200, the cohort module 24126. For example, the cohort module 24126 may extract the first user wagering history in the user database 24116. For example, the user database 24116 may contain the user ID, a device identifier, a paired device identifier, wagering history, or wallet information for the user. Then the cohort module 24126 may compare the extracted user wager history to the cohort database 24132. For example, if the user places ten wagers per week, the user may be placed in cohort one since the requirement for cohort one is that the user places between 5 and 20 wagers a week. Another example may be if the user places 30 wagers a week, then the user may be placed in cohort two since the requirement for cohort two is that the user places between 21 and 49 wagers per week. In some embodiments, the cohorts may be determined by the number wagers of placed by a user, the amount of money wagered by the user, the amount of time spent on the wagering application or wagering platform, the number of friends the user has on the wagering application or wagering platform, the amount of research the user performs on the wagering application or wagering platform, or any combination thereof. The cohort module 24126 may extract the corresponding cohort. For example, the cohort module 24126 may extract the cohort number, such as 1, from the cohort database 24132. Then the cohort module 24126 may store the extracted cohort in the user database 24116. For example, the cohort module 24126 may store cohort 1 in the user database 24116. Then the cohort module 24126 may determine if more users are remaining in the user database 24116. For example, the cohort module 24126 may go through each user in the user database 24116 to assign a cohort to each user. If there are more users in the user database 24116, then the cohort module 24126 may extract the next users wagering history from the user database 24116, and the process may return to comparing the wagering history to the cohort database 24132. If there are no more users remaining in the user database 24116, then the cohort module 24126 may return to the base module 24124. Then the base module 24124 may initiate, at step 24202, the user analytics module 24128. For example, the user analytics module 24128 may continuously poll for the user to select a wager, and then the user may select a wager. The user analytics module 24128 may filter the user database 24116 for the selected wager market and the user ID. Then the user analytics module 24128 may analyze the user's wager history from the filtered user database 24116 and display the user's wager history percentage on the wagering app 24110. Then the user analytics module 24128 may return to the base module 24124. Then the base module 24124 may initiate, at step 24204, the cohort analytics module 24130. For example, the cohort analytics module 24130 may continuously poll for the user to select a wager, and then the user may select a wager. The cohort analytics module 24130 may filter the user database 24116 for the selected wager market and the user cohort, and then the cohort analytics module 24130 may analyze the cohort's wager history from the filtered user database 24116. The cohort analytics module 24130 may display the cohort's wager history percentage on the wagering app 24110, and the cohort analytics module 24130 may return to the base module 24124.

FIG. 243 displays the cohort module 24126. The process may begin with the cohort module 24126 being initiated, at step 24300, by the base module 24124. The cohort module 24126 may extract, at step 24302, a first user wagering history in the user database 24116. For example, the user database 24116 may contain the user ID, a device identifier, a paired device identifier, wagering history, or wallet information for the user. Then the cohort module 24126 may compare, at step 24304, the extracted user wager history to the cohort database 24132. For example, if the user places ten wagers per week, the user may be placed in cohort one since the requirement for cohort one is that the user places between 5 and 20 wagers a week. Another example may be if the user places 30 wagers a week, then the user may be placed in cohort two since the requirement for cohort two is that the user places between 21 and 49 wagers per week. In some embodiments, the cohorts may be determined by the number wagers of placed by a user, the amount of money wagered by the user, the amount of time spent on the wagering application or wagering platform, the number of friends the user has on the wagering application or wagering platform, the amount of research the user performs on the wagering application or wagering platform, or any combination thereof. The cohort module 24126 may extract, at step 24306, the corresponding cohort. For example, the cohort module 24126 may extract the cohort number, such as 1, from the cohort database 24132. Then the cohort module 24126 may store, at step 24308, the extracted cohort in the user database 24116. For example, the cohort module 24126 may store cohort 1 in the user database 24116. The cohort module 24126 may determine, at step 24310, if more users remain in the user database 24116. For example, the cohort module 24126 may go through each user in the user database 24116 to assign a cohort to each user. If more users remain in the user database 24116, then the cohort module may extract, at step 24312, the next users wagering history in the user database 24116, and the process may return to comparing the wagering history to the cohort database 24132 at step 24304. If there are no more users remaining in the user database 24116, then the cohort module 24126 may return, at step 24314, to the base module 24124.

FIG. 244 displays the user analytics module 24128. The process may begin with the user analytics module 24128 being initiated, at step 24400, by the base module 24124. The user analytics module 24128 may continuously poll, at step 24402, for the user to select a wager. For example, the user may select a wager, such as the first pitch in the Boston Red Sox vs. New York Yankees event will be a strike. Then the user may select, at step 24404, a wager. For example, the user may select a wager, such as the first pitch in the Boston Red Sox vs. New York Yankees event will be a strike. The user analytics module 24128 may filter, at step 24406, the user database 24116 for the selected wager market and the user ID. For example, the user database 24116 may be filtered for the user ID, such as JS12345, and the wagering market of the first pitch in events, including the Boston Red Sox vs. New York Yankees. The markets with those common characteristics may be further narrowed to only include instances in which the user wagered the pitch being a strike. In some embodiments, the user database 24116 may be filtered for every instance the user wagered on a baseball event where they wagered that the first pitch would be a strike. Then the user analytics module 24128 may analyze, at step 24408, the user's wager history from the filtered user database 24116. For example, the user analytics module 24128 may determine the number of successful wagers and divide the successful attempts by the number of times the user wagered on the first pitch being a strike in an event, including the Boston Red Sox vs. the New York Yankees. For example, if the user successfully wagered six instances of the first pitch being a strike in an event including the Boston Red Sox vs. the New York Yankees and the total number of instances that the user had placed this wager was 10, then the user's wagering history percentage may be 60% successful. Another example may be if the user selected for the Boston Red Sox's J.D. Martinez to hit a single in an event against the Tampa Rays, then the user database 24116 may be filtered for every instance that the user had wagered on the Boston Red Sox's J. D. Martinez to hit a single in an event against the Tampa Rays. Then the user analytics module 24128 may determine the number of instances in which the user was successful in wagering that the Boston Red Sox's J. D. Martinez hit a single in an event against the Tampa Rays and determine the total number of instances that the user had wagered the Boston Red Sox's J. D. Martinez to hit a single in an event against the Tampa Rays. Then the user analytics module 24128 may divide the successful instances by the total instances to determine the user's wager history percentage, success rate, or success percentage. In another embodiment, success rate could also be determined as a measure of profitability of wagers of a user (or cohort), as desired. For example, if the user had successfully wagered ten times that the Boston Red Sox's J. D. Martinez to hit a single in an event against the Tampa Rays and the total amount of instances that the user wagered that the Boston Red Sox's J. D. Martinez to hit a single in an event against the Tampa Rays was 50, then the user's wagering history percentage, success rate or success percentage may be 20%. The user analytics module 24128 may display, at step 24410, the user's wager history percentage on the wagering app 24110. For example, if the user successfully wagered six instances of the first pitch being a strike in an event including the Boston Red Sox vs. the New York Yankees and the total number of instances that the user had placed this wager was 10, then the user's wagering history percentage may be 60% successful. The user's wager history percentage of 60% successful may be displayed on the wagering app 24110 before the user confirms a wager but after the user selects a wager. Another example may be if the user had successfully wagered ten times that the Boston Red Sox's J. D. Martinez to hit a single in an event against the Tampa Rays and the total amount of instances that the user wagered that the Boston Red Sox's J. D. Martinez to hit a single in an event against the Tampa Rays was 50, then the user's wagering history percentage, success rate or success percentage may be 20% and this may be displayed on the wagering app 24110. In some embodiments, the successful wager percentage may be displayed before the user selects the wager by determining the user's successful wager percentage for every wager displayed on the wagering app 24110 within the wagering market displayed. Then the user analytics module 24128 may return, at step 24412, to the base module 24124.

FIG. 245 displays the cohort analytics module 24130. The process may begin with the cohort analytics module 24130 being initiated, at step 24500, by the base module 24124. The cohort analytics module 24130 may continuously poll, at step 24502, for the user to select a wager. For example, the user may select a wager, such as the first pitch in the Boston Red Sox vs. New York Yankees event will be a strike. Then the user may select, at step 24504, a wager. For example, the user may select a wager, such as the first pitch in the Boston Red Sox vs. New York Yankees event will be a strike. The cohort analytics module 24130 may filter, at step 24506, the user database 24116 for the selected wager market and the user cohort. For example, the user database 24116 may be filtered for the user's cohort, such as cohort 1, and the wagering market of the first pitch in events, including the Boston Red Sox vs. New York Yankees in which the user wagered the pitch will be a strike. In some embodiments, the user database 24116 may be filtered for every instance the cohort wagered on a baseball event where they wagered that the first pitch would be a strike. Then the cohort analytics module 24130 may analyze, at step 24508, the cohort's wager history from the filtered user database 24116. For example, the cohort analytics module 24130 may determine the number of successful wagers and divide the successful attempts by the number of times the cohort wagered on the first pitch being a strike in an event, including the Boston Red Sox vs. the New York Yankees. For example, if the users in the cohort successfully wagered 50 instances of the first pitch being a strike in an event including the Boston Red Sox vs. the New York Yankees and the total number of instances that the cohort had placed this wager was 100, then the users in the cohort wagering history percentage may be 50% successful. Another example may be if the user selected for the Boston Red Sox's J. D. Martinez to hit a single in an event against the Tampa Rays, then the user database 24116 may be filtered for every instance that the users in the same cohort had wagered on the Boston Red Sox's J. D. Martinez to hit a single in an event against the Tampa Rays. Then the cohort analytics module 24130 may determine the number of instances in which the users in the cohort were successful in wagering that the Boston Red Sox's J. D. Martinez hit a single in an event against the Tampa Rays and determine the total number of instances that the user had wagered the Boston Red Sox's J. D. Martinez to hit a single in an event against the Tampa Rays. Then the cohort analytics module 24130 may divide the successful instances by the total instances to determine the cohort wager history percentage, success rate, or success percentage. For example, if the users in the cohort had successfully wagered 200 times that the Boston Red Sox's J. D. Martinez to hit a single in an event against the Tampa Rays and the total amount of instances that the users in the cohort wagered that the Boston Red Sox's J. D. Martinez to hit a single in an event against the Tampa Rays was 500, then the users in the cohort wagering history percentage, success rate or success percentage may be 40%. The cohort analytics module 24130 may display, at step 24510, the cohort's wager history percentage on the wagering app 24110. The display may be on a user device, devices of users in the cohort, or on a device or application associated with a sportsbook or the wagering network, who may, for example, use this information to perform further analytics or otherwise adjust available wagers or features on a wagering network. For example, if the users in the cohort successfully wagered 50 instances of the first pitch being a strike in an event including the Boston Red Sox vs. the New York Yankees and the total number of instances that the cohort had placed this wager was 100, then the users in the cohort wagering history percentage may be 50% successful. The cohort's wager history percentage of being 50% successful may be displayed on the wagering app 24110 (or another device or application associated with a sportsbook or wagering network) before the user confirms a wager but after the user selects a wager. Another example may be if the users in the cohort had successfully wagered 200 times that the Boston Red Sox's J. D. Martinez to hit a single in an event against the Tampa Rays and the total amount of instances that the users in the cohort wagered that the Boston Red Sox's J. D. Martinez to hit a single in an event against the Tampa Rays was 500, then the users in the cohort wagering history percentage, success rate or success percentage may be 40%. This 40% wagering history percentage may be displayed on the wagering app 24110 (or may be made available to a device associated with a sportsbook administrator, wagering network, or skilled game operator (SGO), as desired). In some embodiments, the successful wager percentage may be displayed before the user selects a wager by determining the cohort's successful wager percentage for every wager displayed on the wagering app 24110 within the wagering market displayed. Then the cohort analytics module 24130 may return, at step 24512, to the base module 24124. Alternatively, and further, the successful wager information or other wager analytics of a user or cohort may be displayed on a device or application associated with a sportsbook or otherwise associated with the wagering network.

FIG. 246 displays the cohort database 24132. The cohort database 24132 may contain the cohort, such as 1, 2, 3, etc. and the requirement for the user to be placed in that cohort, such as the user places 5-20 wagers a week; the user places 21-49 wagers a week, the user places 50 or more wagers a week. The cohort database 24132 may be used in the process described in the cohort module 24126 to place users in cohorts that represent their skill level for the wagering app 24110. In some embodiments, the cohort database 24132 requirements may use historical wagering patterns over a day, week, month, year, etc. In some embodiments, the cohort database 24132 requirements may be based on a monetary value, such as the more money spent by a user, the higher the cohort. In some embodiments, the cohorts may be determined by the number wagers of placed by a user, the amount of money wagered by the user, the amount of time spent on the wagering application or wagering platform, the number of friends the user has on the wagering application or wagering platform, the amount of research the user performs on the wagering application or wagering platform, or any combination thereof.

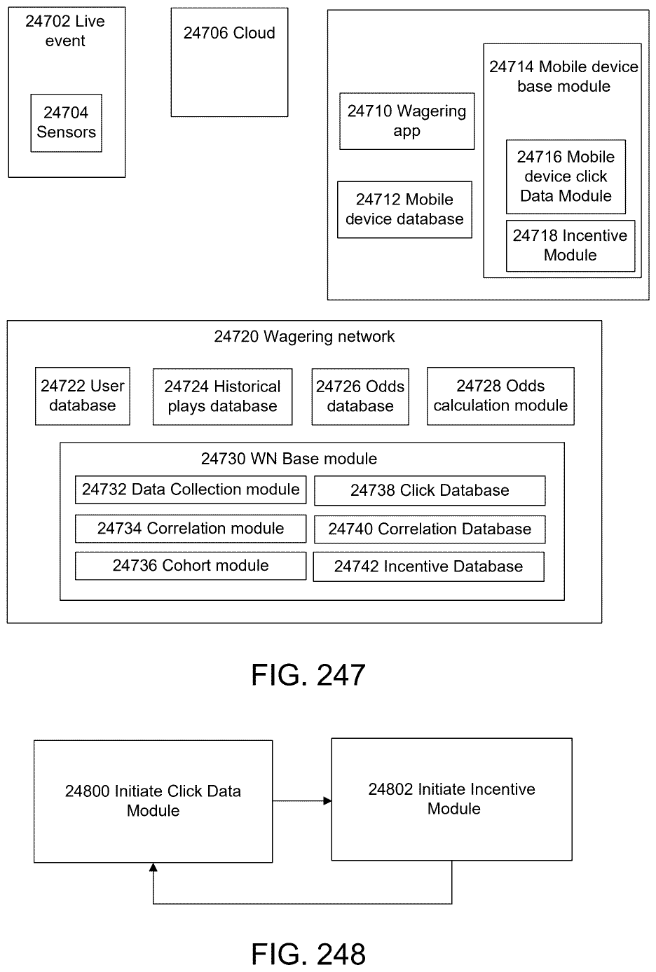

FIG. 247: illustrates a cohort creation system, according to an embodiment.

FIG. 248: illustrates a base module, according to an embodiment.

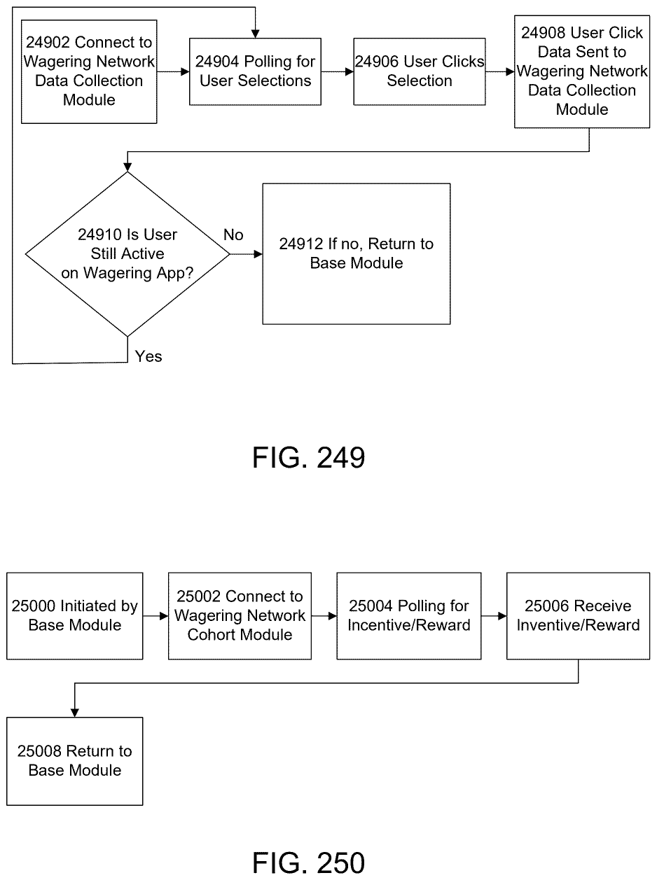

FIG. 249: illustrates a click data module, according to an embodiment.

FIG. 250: illustrates an incentive module, according to an embodiment.

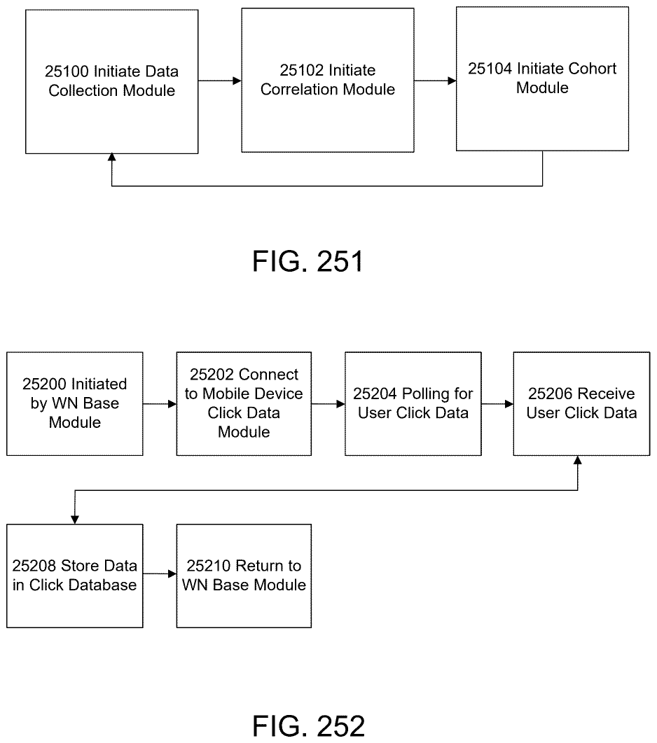

FIG. 251: illustrates a base module, according to an embodiment.

FIG. 252: illustrates a data collection module, according to an embodiment.

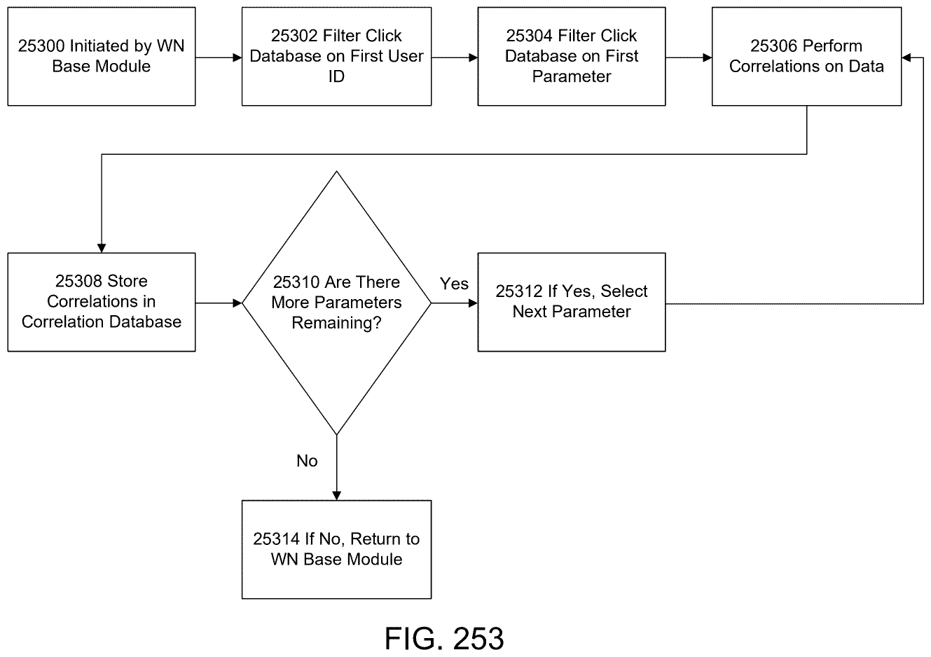

FIG. 253: illustrates a correlation module, according to an embodiment.

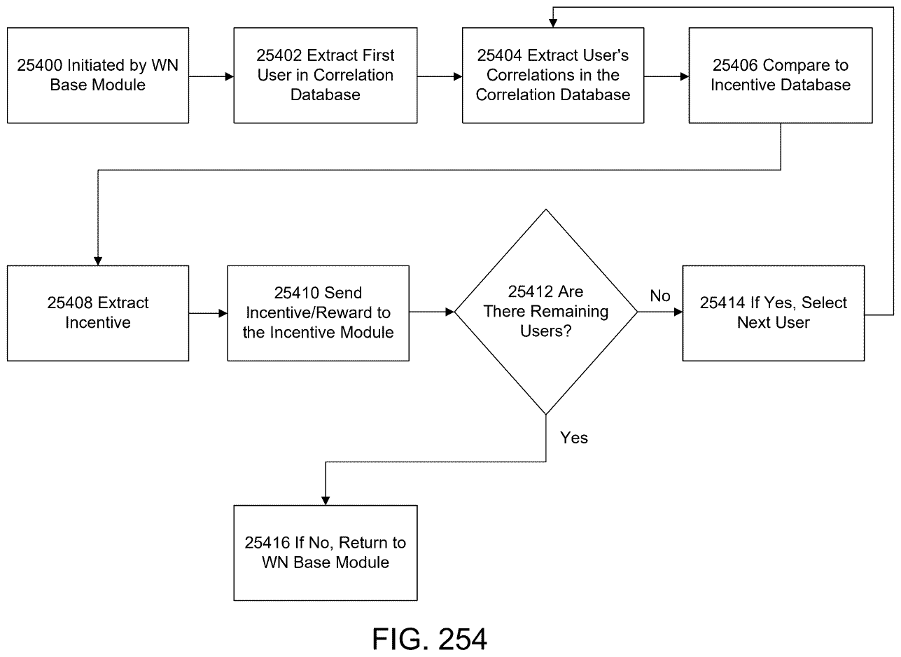

FIG. 254: illustrates a cohort module, according to an embodiment.

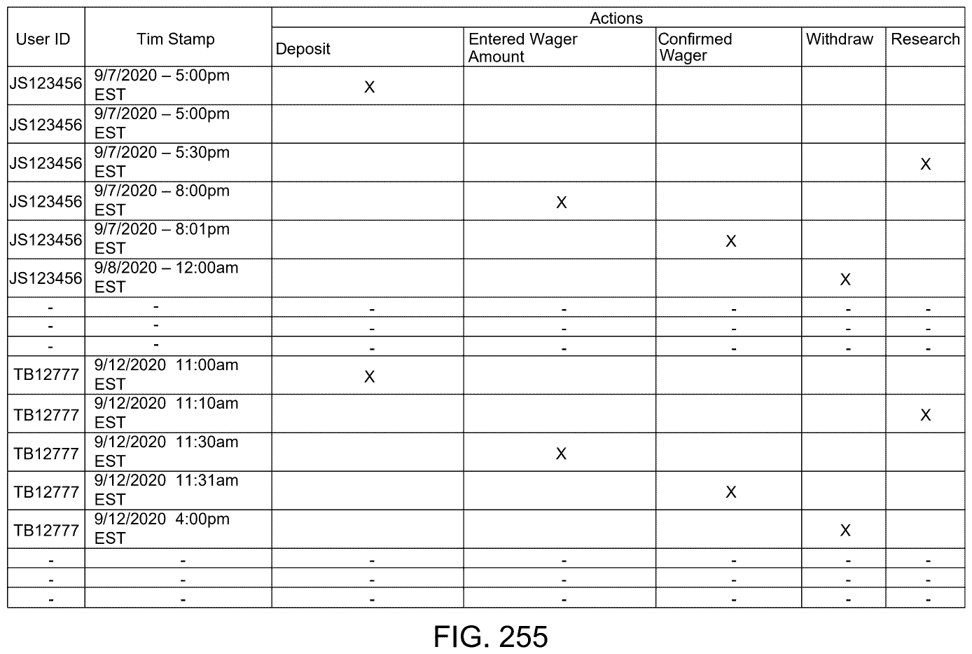

FIG. 255: illustrates a click database, according to an embodiment.

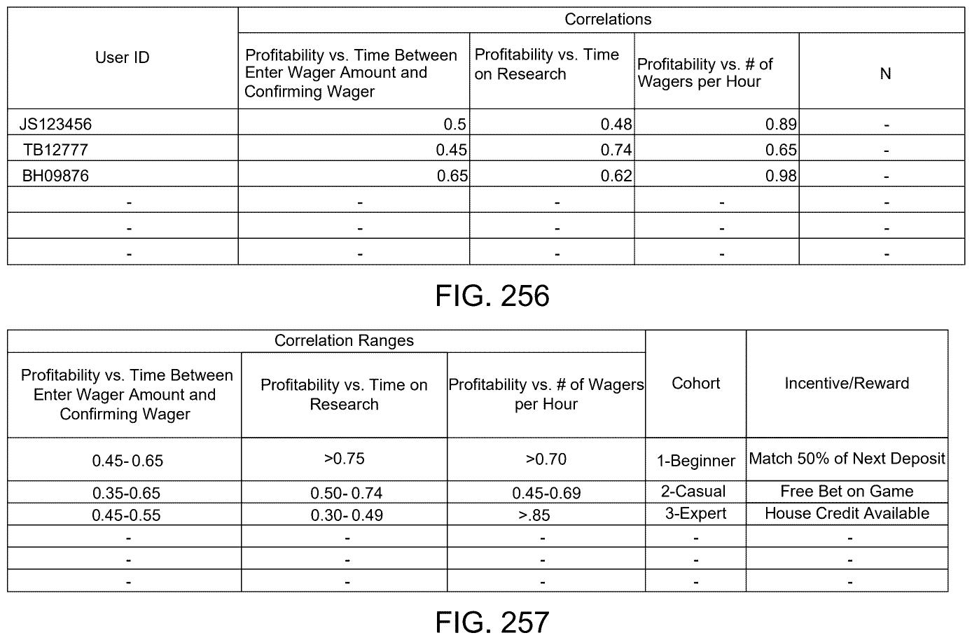

FIG. 256: illustrates a correlations database, according to an embodiment.

FIG. 257: illustrates an incentive database, according to an embodiment.

FIG. 247 displays is a cohort creation system. This system may include a live event 24702, for example, a sporting event such as a football, basketball, baseball, or hockey game, tennis match, golf tournament, eSports or digital game, etc. The live event 24702 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 24702, such as the score of an American football game or the run line in a baseball game, or a series of actions in the live event 24702. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live event 24702 in the future. Sportsbooks need to offer payment processing services to cash out customers which can be done at kiosks at the live event 24702 or at another location.

Further, embodiments may include a plurality of sensors 24704 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 24704 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 24706 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 24706 may be communicatively coupled to a peer-to-peer wagering network 24720, which may perform real-time analysis on the type of play and the result of the play. The cloud 24706 may also be synchronized with game situational data such as the time of the game, the score, location on the field, weather conditions, and the like, which may affect the choice of play utilized. For example, in an exemplary embodiment, the cloud 24706 may not receive data gathered from the sensors 24704 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 24708 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 24708 could be an optional component and would be utilized in a situation where a paired wearable device employs the mobile device 24708 for additional memory or computing power or connection to the internet.

Further, embodiments may include a wagering software application or a wagering app 24710, which is a program that enables the user to place bets on individual plays in the live event 24702, streams audio and video from the live event 24702, and features the available wagers from the live event 24702 on the mobile device 24708. The wagering app 24710 allows the user to interact with the wagering network 24720 to place bets and provide payment/receive funds based on wager outcomes.

Further, embodiments may include a mobile device database 24712 that may store some or all the user's data, the live event 24702, or the user's interaction with the wagering network 24720. Further, embodiments may include a mobile device base module 24714 that initiates a mobile device click data module 24716, which collects and sends the user selections or clicks of actions, buttons, prompts, etc. on the wagering app 24710 user interface such as deposit funds, enter a wager amount, confirm wager, withdraw funds, click on a research article, select a matchup, game, or event, etc. to a wagering network data collection module 24732. Then the mobile device base module 24714 initiates a mobile device incentive module 24718, which connects to a wagering network cohort module 24736 and receives an incentive or reward from the wagering network cohort module 24736.

Further, embodiments may include the mobile device click data module 24716, which connects to the wagering network data collection module 24732. Then the user may click a selection on the wagering app 24710 user interface. For example, the user selects or clicks an action, button, prompt, etc., on the wagering app 24710 user interface such as deposit funds, enter a wager amount, confirm wager, withdraw funds, click on a research article, select a matchup, game, or event, etc. Then the mobile device 24708 click data module 24716 is sent to the wagering network data collection module 24732. For example, the mobile device 24708 click data module 24716 send the selection of the user such as selecting or clicking an action, button, prompt, etc. on the wagering app 24710 user interface such as deposit funds, enter a wager amount, confirm wager, withdraw funds, click on a research article, select a matchup, game, or event, etc. along with the timestamp of the selection and the user's user ID.

Further, embodiments may include the mobile device 24708 incentive module 24718, which connects to the wagering network cohort module 24736. Then the mobile device 24708 incentive module 24718 continuously polls for the incentive or reward from the wagering network cohort module 24736. For example, depending on what cohort or group the user is identified in, such as a beginner, casual, or an expert gambler, the user may receive an incentive or reward from the wagering network cohort module 24736 depending on the user's behavioral tendencies derived from the click data that was sent to the wagering network data collection module 24732. For example, the rewards may be matching a user deposit up to a certain amount or certain percentage, offering the user a free bet or wager, offering the user a line of house credit, etc. Then the mobile device 24708 incentive module 24718 receives the incentive or reward from the wagering network cohort module 24736. For example, the rewards may be matching a user deposit up to a certain amount or certain percentage, offering the user a free bet or wager, offering the user a line of house credit, etc. In some embodiments, the user may receive a notification on the mobile device 24708 that they have received an incentive or reward from the wagering network 24720.

Further, embodiments may include the wagering network 24720, which may perform real-time analysis on the type of play and the result of a play or action. The wagering network 24720 (or the cloud 24706) may also be synchronized with game situational data, such as the time of the game, the score, location on the field, weather conditions, and the like, which may affect the choice of play utilized. For example, in an exemplary embodiment, the wagering network 24720 may not receive data gathered from the sensors 24704 and may, instead, receive data from an alternative data feed, such as SportsRadar®. This data may be provided substantially immediately following the completion of any play, and may be compared with a variety of team data and league data based on a variety of elements, including the current down, possession, score, time, team, and so forth, as described in various exemplary embodiments herein. The wagering network 24720 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user. Further, embodiments may include a user database 24722, which may contain data relevant to all users of the wagering network 24720 and may include, but is not limited to, a user ID, a device identifier, a paired device identifier, wagering history, or wallet information for the user. The user database 24722 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 24722 may contain betting lines and search queries. The user database 24722 may be searched based on a search criterion received from the user. Each betting line may include, but is not limited to, a plurality of betting attributes such as at least one of the live event 24702, a team, a player, an amount of wager, etc. The user database 24722 may include, but is not limited to, information related to all the users involved in the live event 24702. In one exemplary embodiment, the user database 24722 may include information for generating a user authenticity report and a wagering verification report. Further, the user database 24722 may be used to store user statistics like, but not limited to, the retention period for a particular user, frequency of wagers placed by a particular user, the average amount of wager placed by each user, etc. Further, embodiments may include a historical play database 24724 that may contain play data for the type of sport being played in the live event 24702. For example, in American Football, for optimal odds calculation, the historical play data may include metadata about the historical plays, such as time, location, weather, previous plays, opponent, physiological data, etc.

Further, embodiments may utilize an odds database 24726—that contains the odds calculated by an odds calculation module 24728—to display the odds on the user's mobile device 24708 and take bets from the user through the mobile device wagering app 24710. Further, embodiments may include an odds calculation module 24728, which utilizes historical play data to calculate odds for in-play wagers.

Further, embodiments may include a WN base module 24730, which may initiate the wagering network data collection module 24732, which collects and stores the received click data from the mobile device click data module 24716, a wagering network correlation module 24734, and which performs correlations on all the received click data and stores the resulting correlation coefficients in a wagering network correlation database 24740, and the wagering network cohort module 24736 which compares the correlation coefficients stored in the wagering network correlation database 24740 to a wagering network incentive database 24742 to determine which cohort the user belongs to and extracts the corresponding incentive or reward and sends it to the user.

Further, embodiments may include the wagering network data collection module 24732, which connects to the mobile device click data module 24716. The wagering network data collection module 24732 receives the user-click data from the mobile device click data module 24716. For example, the mobile device click data module 24716 is sending the selections of the user such as selecting or clicking an action, button, prompt, etc. on the wagering app 24710 user interface such as deposit funds, enter a wager amount, confirm wager, withdraw funds, click on a research article, select a matchup, game, or event, etc. along with the timestamp of the selection and the user's user ID. Then the wagering network data collection module 24732 stores the received click data in a wagering network click database 24738. For example, the wagering network click database 24738 contains the user ids of the various users, the timestamps of an action, selection, or click of the user, and what the action, selection, or click was, such as depositing funds, entering a wager amount, confirming a wager, selecting a research page or article, withdrawing funds, etc. and returns to the WN base module 24730.

Further, embodiments may include the wagering network correlation module 24734 that filters the wagering network click database 24738 on the first user ID and filters the wagering network click database 24738 on the first parameter, for example, the times that the user deposited funds into their account. The wagering network correlation module 24734 performs correlations on the data. For example, the wagering network click database 24738 is filtered on the user ID and one of the parameters, such as user depositing funds into the account or user's profitability for the house (funds the house has gained), and then correlations are performed on the rest of the parameters with the selected parameter that has filtered the database, such as times when the user has entered a wager amount, confirmed a wager amount, selected a research page, withdrew funds, etc. Then the wagering network correlation module 24734 stores the correlations in the wagering network correlation database 24740 along with the user ID.

Further, embodiments may include the wagering network cohort module 24736 which may extract the user ID in the wagering network correlation database 24740 and extracts the user's correlation coefficients stored in the wagering network correlation database 24740; for example, for user ID JS123456 the correlation coefficients that are extracted are 0.5, for profitability vs. time between entered wager amount and confirmed wager amount, 0.48 for profitability vs. time on the research page, and 0.89 for profitability vs. the number of wagers per hour. Then the wagering network cohort module 24736 compares the extracted correlations to the wagering network incentive database 24742. For example, the extracted correlation coefficients of 0.5, for profitability vs. time between entered wager amount and confirmed wager amount, 0.48 for profitability vs. time on the research page, and 0.89 for profitability vs. the number of wagers per hour are compared to the correlation coefficient ranges in the wagering network incentive database 24742 which allows the system to place a user within a specific cohort or group such as a beginner, casual, or expert gambler. Then the wagering network cohort module 24736 extracts the corresponding incentive stored in the wagering network incentive database 24742. For example, the user with the user ID JS123456 has correlation coefficients of 0.5 for profitability vs. time between entered wager amount and confirmed wager amount, 0.48 for profitability vs. time on the research page, and 0.89 for profitability vs. the number of wagers per hour, which would put user ID JS123456 in cohort “3-Expert” and the corresponding incentive or reward would be that a line of house credit would be available to the user. Then the wagering network cohort module 24736 sends the incentive or reward to the user.

Further, embodiments may include the wagering network click database 24738, which contains the user ids of the various users, the timestamps of an action, selection, or click of the user, and what the action, selection, or click was, such as depositing funds, entering a wager amount, confirming a wager, selecting a research page or article, withdrawing funds, etc.

Further, embodiments may include the wagering network correlation database 24740, which contains the correlation coefficients stored for each user from the process described in the wagering network correlation module 24734. The database contains the user ID, the parameters that are related to the correlation, for example, profitability vs. time between entering a wager amount and confirming wager amount, profitability vs. time on a research page or article, profitability vs. the number of wagers per hour, and N represents the infinite number of combinations of parameters that may have associated correlation coefficients.

Further, embodiments may include the wagering network incentive database 24742, which contains correlation coefficient ranges, the corresponding cohort, and incentive or reward for a user. The database is used in the process described in the wagering network cohort module 24736 in which a user's correlation coefficients, which are determined in the process described in the wagering network correlation module 24734, are extracted from the wagering network correlation database 24740 and compared to the wagering network incentive database 24742 to determine which cohort or group a user belongs to.

FIG. 248 displays the mobile device base module 24714. The process begins with the mobile device base module 24714 initiating; at step 24800, the mobile device click data module 24716. For example, the mobile device base module 24714 initiates the mobile device click data module 24716. Then the mobile device click data module connects to the wagering network data collection module 24732. The mobile device click data module 24716 continuously polls for the user selections. For example, the mobile device click data module 24716 is waiting for the user to select or click an action, button, prompt, etc. on the wagering app 24710 user interface such as deposit funds, enter a wager amount, confirm wager, withdraw funds, click on a research article, select a matchup, game, or event, etc. Then the user clicks a selection on the wagering app 24710 user interface. For example, the user selects or clicks an action, button, prompt, etc., on the wagering app 24710 user interface such as deposit funds, enter a wager amount, confirm wager, withdraw funds, click on a research article, select a matchup, game, or event, etc. Then the mobile device click data module 24716 is sent to the wagering network data collection module 24732. For example, the mobile device click data module 24716 sends the selection of the user such as selecting or clicking an action, button, prompt, etc. on the wagering app 24710 user interface such as deposit funds, enter a wager amount, confirm wager, withdraw funds, click on a research article, select a matchup, game, or event, etc. along with the timestamp of the selection and the user's user ID. Then it is determined if the user is still active on the wagering app 24710, for example, if the user is still logged on to the wagering app 24710. If it is determined that the user is still active on the wagering app 24710, then the process returns to continuously polling for the user selections. If it is determined that the user is no longer active on the wagering app 24710, then the process returns to the mobile device base module 24714. Then the mobile device base module 24714 initiates, at step 24802, the mobile device incentive module 24718. Then the mobile device incentive module 24718 connects to the wagering network cohort module 24736. Then the mobile device incentive module 24718 continuously polls for the incentive or reward from the wagering network cohort module 24736. For example, depending on what cohort or group the user is identified in, such as a beginner, casual, or an expert gambler, the user may receive an incentive or reward from the wagering network cohort module 24736 depending on the user's behavioral tendencies derived from the click data that was sent to the wagering network data collection module 24732. For example, the rewards may be matching a user deposit up to a certain amount or certain percentage, offering the user a free bet or wager, offering the user a line of house credit, etc. Then the mobile device incentive module 24718 receives the incentive or reward from the wagering network cohort module 24736. Then the mobile device incentive module 24718 returns to the mobile device base module 24714.

FIG. 249 illustrates the mobile device click data module 24716. The process begins with the mobile device base module 24714 initiating; at step 24900, the mobile device click data module 24716. Then the mobile device click data module 24716 connects, at step 24902, to the wagering network data collection module 24732. The mobile device click data module 24716 continuously polls, at step 24904, for the user selections. For example, the mobile device click data module 24716 is waiting for the user to select or click an action, button, prompt, etc. on the wagering app 24710 user interface such as deposit funds, enter a wager amount, confirm wager, withdraw funds, click on a research article, select a matchup, game, or event, etc. Then the user clicks, at step 24906, a selection on the wagering app 24710 user interface. For example, the user selects or clicks an action, button, prompt, etc., on the wagering app 24710 user interface such as deposit funds, enter a wager amount, confirm wager, withdraw funds, click on a research article, select a matchup, game, or event, etc. Then the mobile device click data module 24716 is sent, at step 24908, to the wagering network data collection module 24732. For example, the mobile device click data module 24716 is sending the selection of the user such as selecting or clicking an action, button, prompt, etc. on the wagering app 24710 user interface such as deposit funds, enter a wager amount, confirm wager, withdraw funds, click on a research article, select a matchup, game, or event, etc. along with the timestamp of the selection and the user's user ID. Then it is determined, at step 24910, if the user is still active on the wagering app 24710, for example, if the user is still logged on to the wagering app 24710. If it is determined that the user is still active on the wagering app 24710, then the process returns to step 24904, where the mobile device click data module 24716 continuously polls for the user selections. If it is determined that the user is no longer active on the wagering app 24710, then the process returns, at step 24912, to the mobile device base module 24714.

FIG. 250 displays the mobile device incentive module 24718. The process begins with the mobile device base module 24714 initiating, at step 25000, the mobile device incentive module 24718. Then the mobile device incentive module 24718 connects, at step 25002, to the wagering network cohort module 24736. Then the mobile device incentive module 24718 continuously polls, at step 25004, for the incentive or reward from the wagering network cohort module 24736. For example, depending on what cohort or group the user is identified in, such as a beginner, casual, or an expert gambler, the user may receive an incentive or reward from the wagering network cohort module 24736 depending on the user's behavioral tendencies derived from the click data that was sent to the wagering network data collection module 24732. For example, the rewards may be matching a user deposit up to a certain amount or certain percentage, offering the user a free bet or wager, offering the user a line of house credit, etc. Then the mobile device incentive module 24718 receives, at step 25006, the incentive or reward from the wagering network cohort module 24736. For example, the rewards may be matching a user deposit up to a certain amount or certain percentage, offering the user a free bet or wager, offering the user a line of house credit, etc. In some embodiments, the user may receive a notification on the mobile device 24708 that they have received an incentive or reward from the wagering network 24720. Then the mobile device incentive module 24718 returns, at step 25008, to the mobile device base module 24714.

FIG. 251 displays the WN base module 24730. The process begins with the WN base module 24730 initiating, at step 25100, the wagering network data collection module 24732. The wagering network data collection module 24732 connects to the mobile device click data module 24716. The wagering network data collection module 24732 receives the user-click data from the mobile device click data module 24716. For example, the mobile device click data module 24716 sends the selections of the user such as selecting or clicking an action, button, prompt, etc. on the wagering app 24710 user interface such as deposit funds, enter a wager amount, confirm wager, withdraw funds, click on a research article, select a matchup, game, or event, etc. along with the timestamp of the selection and the user's user ID. Then the wagering network data collection module 24732 stores the received click data in the wagering network click database 24738. The wagering network click database 24738 contains the user ids of the various users, the timestamps of an action, selection, or click of the user, and what the action, selection, or click was, such as depositing funds, entering a wager amount, confirming a wager, selecting a research page or article, withdrawing funds, etc. and returns to the WN base module 24730. Then the WN base module 24730 initiates, at step 25102, the wagering network correlation module 24734. The wagering network correlation module 24734 filters the wagering network click database 24738 on the first user ID and filters the wagering network click database 24738 on the first parameter, for example, the times that the user deposited funds into their account. The wagering network correlation module 24734 performs correlations on the data. For example, the wagering network click database 24738 is filtered on the user ID and one of the parameters, such as user depositing funds into the account or user's profitability for the house (funds the house has gained), and then correlations are performed on the rest of the parameters with the selected parameter that has filtered the database, such as times when the user has entered a wager amount, confirmed a wager amount, selected a research page, withdrew funds, etc. Then the wagering network correlation module 24734 stores the correlations in the wagering network correlation database 24740 along with the user ID. The WN base module 24730 then initiates, at step 25104, the wagering network cohort module 24736. The wagering network cohort module 24736 extracts the user ID in the wagering network correlation database 24740 and extracts the user's correlation coefficients stored in the wagering network correlation database 24740; for example, for user ID JS123456 the correlation coefficients that are extracted are 0.5, for profitability vs. time between entered wager amount and confirmed wager amount, 0.48 for profitability vs. time on the research page, and 0.89 for profitability vs. the number of wagers per hour. Then the wagering network cohort module 24736 compares the extracted correlations to the wagering network incentive database 24742. For example, the extracted correlation coefficients of 0.5, for profitability vs. time between entered wager amount and confirmed wager amount, 0.48 for profitability vs. time on the research page, and 0.89 for profitability vs. the number of wagers per hour are compared to the correlation coefficient ranges in the wagering network incentive database 24742 which allows the system to place a user within a specific cohort or group such as a beginner, casual, or expert gambler. Then the wagering network cohort module 24736 extracts the corresponding incentive stored in the wagering network incentive database 24742. For example, the user with the user ID JS123456 has correlation coefficients of 0.5 for profitability vs. time between entered wager amount and confirmed wager amount, 0.48 for profitability vs. time on the research page, and 0.89 for profitability vs. the number of wagers per hour, which would put user ID JS123456 in cohort “3-Expert” and the corresponding incentive or reward would be that a line of house credit would be available to the user. Then the wagering network cohort module 24736 sends the incentive or reward to the user.

FIG. 252 display the wagering network data collection module 24732. The process begins with the WN base module 24730 initiating, at step 25200, the wagering network data collection module 24732. Then the wagering network data collection module 24732 connects, at step 25202, to the mobile device click data module 24716. The mobile device click data module 24716 collects the user's interactions, such as clicks or selections of an action, button, prompt, etc., on the wagering app 24710. Then the wagering network data collection module 24732 continuously polls, at step 25204, for the user click data from the mobile device click data module 24716. For example, the mobile device click data module 24716 collects the user's selections or click of an action, button, prompt, etc. on the wagering app 24710 user interface such as deposit funds, enter a wager amount, confirm wager, withdraw funds, click on a research article, select a matchup, game, or event, etc. The wagering network data collection module 24732 receives, at step 25206, the user click data from the mobile device click data module 24716. For example, the mobile device click data module 24716 is sending the selections of the user such as selecting or clicking an action, button, prompt, etc. on the wagering app 24710 user interface such as deposit funds, enter a wager amount, confirm wager, withdraw funds, click on a research article, select a matchup, game, or event, etc. along with the timestamp of the selection and the user's user ID. Then the wagering network data collection module 24732 stores, at step 25208, the received click data in the wagering network click database 24738. For example, the wagering network click database 24738 contains the user ids of the various users, the timestamps of an action, selection, or click of the user, and what the action, selection, or click was, such as depositing funds, entering a wager amount, confirming a wager, selecting a research page or article, withdrawing funds, etc. Then the wagering network data collection module 24732 returns, at step 25210, to the WN base module 24730.

FIG. 253 illustrates the wagering network correlation module 24734. The process begins with the WN base module 24730 initiating, at step 25300, the wagering network correlation module 24734. Then the wagering network correlation module 24734 filters, at step 25302, the wagering network click database 24738 on the first user ID. For example, the wagering network correlation module 24734 filters the wagering network click database 24738 on the user ID JS123456. Then the wagering network correlation module 24734 filters, at step 25304, the wagering network click database 24738 on the first parameter, for example, the times that the user deposited funds into their account. The wagering network correlation module 24734 performs, at step 25306, correlations on the data. For example, the wagering network click database 24738 is filtered on the user ID and one of the parameters, such as user depositing funds into the account or user's profitability for the house (funds the house has gained), and then correlations are performed on the rest of the parameters with the selected parameter that has filtered the database, such as times when the user has entered a wager amount, confirmed a wager amount, selected a research page, withdrew funds, etc. For example, the wagering network click database 24738 is filtered on the user ID, and one of the parameters, such as the time between a wager amount, is entered and then confirmed by a user and a user's profitability for the house (funds the house has gained). An example of correlated parameters is with the house profitability vs. the time between a user has entered a wager amount and confirmed the wager amount with a 0.50 correlation coefficient; this correlation is extracted and stored in the wagering network correlation database 24740. In another example, the wagering network click database 24738 is filtered on the user ID and one of the parameters, such as a user's time spent on a research page and a user's profitability for the house (funds the house has gained). An example of correlated parameters is with the house profitability vs. the time a user has spent on a research page with a 0.48 correlation coefficient, and this correlation is extracted and stored in the wagering network correlation database 24740. An additional example may be, the wagering network click database 24738 is filtered on the user ID and one of the parameters, such as a user's number of wagers per hour and a user's profitability for the house (funds the house has gained). An example of correlated parameters is with the house profitability vs. the number of wagers per hour with a 0.89 correlation coefficient, and this correlation is extracted and stored in the wagering network correlation database 24740. Then the wagering network correlation module 24734 stores, at step 25308, the correlations from step 25306 in the wagering network correlation database 24740 along with the user ID. For example, for user ID JS123456 the correlation coefficient of 0.50 for the house profitability vs. the time between a user has entered a wager amount and confirmed the wager amount, the correlation coefficient of 0.48 for the house profitability vs. the time a user has spent on a research page, and the correlation coefficient of 0.89 for the house profitability vs. the number of wagers per hour are stored in the wagering network correlation database 24740. Then the wagering network correlation module 24734 determines, at step 25310, if more parameters are remaining. If it is determined that more parameters are remaining, the wagering network correlation module 24734 selects, at step 25312, the next parameter and returns to step 25306. If it is determined that there are no more parameters remaining, then the wagering network correlation module 24734 returns, at step 25314, to the WN base module 24730.

FIG. 254 illustrates the wagering network cohort module 24736. The process begins with the WN base module 24730 initiating, at step 25400, the wagering network cohort module 24736. Then the wagering network cohort module 24736 extracts, at step 25402, the first user ID in the wagering network correlation database 24740, for example, the user ID JS123456. Then the wagering network cohort module 24736 extracts, at step 25404, the user's correlation coefficients stored in the wagering network correlation database 24740, for example, for user ID JS123456 the correlation coefficients that are extracted are 0.5, for profitability vs. time between entered wager amount and confirmed wager amount, 0.48 for profitability vs. time on the research page, and 0.89 for profitability vs. the number of wagers per hour. Then the wagering network cohort module 24736 compares, at step 25406, the extracted correlations to the wagering network incentive database 24742. For example, the extracted correlation coefficients of 0.5, for profitability vs. time between entered wager amount and confirmed wager amount, 0.48 for profitability vs. time on the research page, and 0.89 for profitability vs. the number of wagers per hour are compared to the correlation coefficient ranges in the wagering network incentive database 24742 which allows the system to place a user within a specific cohort or group such as a beginner, casual, or expert gambler. Then the wagering network cohort module 24736 extracts, at step 25408, the corresponding incentive stored in the wagering network incentive database 24742. For example, the user with the user ID JS123456 has correlation coefficients of 0.5 for profitability vs. time between entered wager amount and confirmed wager amount, 0.48 for profitability vs. time on the research page, and 0.89 for profitability vs. the number of wagers per hour, which would put user ID JS123456 in cohort “3-Expert” and the corresponding incentive or reward would be that a line of house credit would be available to the user. Then the wagering network cohort module 24736 sends, at step 25410, the incentive or reward to the mobile device incentive module 24718; for example, a notification to user ID JS123456 would be sent notifying that they are eligible for a line of house credit. Then the wagering network cohort module 24736 determines, at step 25412, if any users are remaining. If it is determined that more users are remaining, the wagering network cohort module 24736 selects, at step 25414, the next user and returns to step 25404. If it is determined that there are no more users remaining, then the wagering network cohort module 24736 returns, at step 25416, to the WN base module 24730.

FIG. 255 illustrates the wagering network click database 24738, which contains the user ids of the various users, the timestamps of an action, selection, or click of the user, and what the action, selection, or click was, such as depositing funds, entering a wager amount, confirming a wager, selecting a research page or article, withdrawing funds, etc. In some embodiments, the database may contain additional data such as the sequence of events of a user and how long the sequence took, for example, if the user deposited funds, entered a wager amount, and confirmed a wager within five minutes. In some embodiments, the database may contain how long a user stayed on a page on the wagering network 24720, for example, how long the user took to decide which game, matchup, or event to select. In some embodiments, the database may contain time data broken down by certain periods such as minutes, hours, days, weeks, quarters, years, etc., such as how many bets were placed during that time period.

FIG. 256 displays the wagering network correlation database 24740, which contains the correlation coefficients stored for each user from the process described in the wagering network correlation module 24734. The database contains the user ID, the parameters that are related to the correlation, for example, profitability vs. time between entering a wager amount and confirming wager amount, profitability vs. time on a research page or article, profitability vs. the number of wagers per hour, and N represents the infinite number of combinations of parameters that may have associated correlation coefficients. These correlation coefficients are extracted during the process described in the wagering network cohort module 24736 to determine the user's behavioral tendencies and place the user in a cohort or group representing those behaviors such as a beginner, casual, or expert gambler.

FIG. 257 displays the wagering network incentive database 24742, which contains correlation coefficient ranges, the corresponding cohort, and incentive or reward for a user. The database is used in the process described in the wagering network cohort module 24736 in which a user's correlation coefficients, which are determined in the process described in the wagering network correlation module 24734, are extracted from the wagering network correlation database 24740 and compared to the wagering network incentive database to determine which cohort or group a user belongs to. For example, a user with correlation coefficients of 0.5, for profitability vs. time between entered wager amount and confirmed wager amount, 0.48 for profitability vs. time on the research page, and 0.89 for profitability vs. the number of wagers per hour, which would put user ID JS123456 in cohort “3-Expert” and the corresponding incentive or reward would be that a line of house credit would be available to the user.

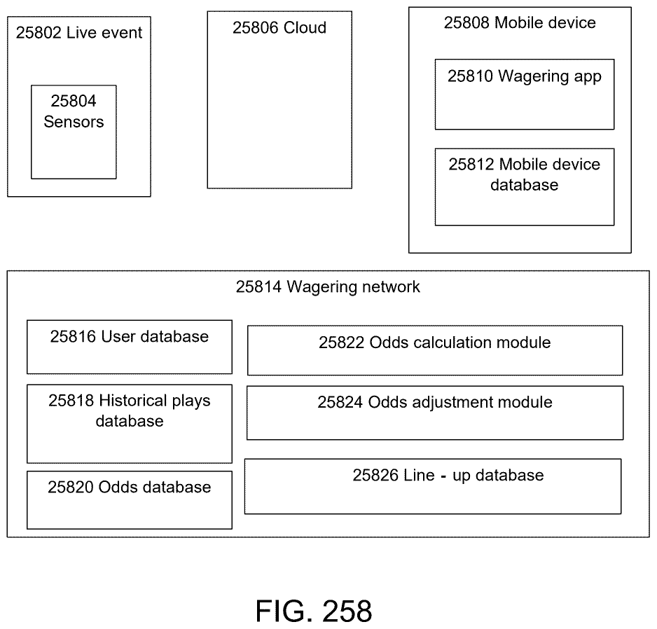

FIG. 258 illustrates a system for lineup-based odds adjustment, according to an embodiment.

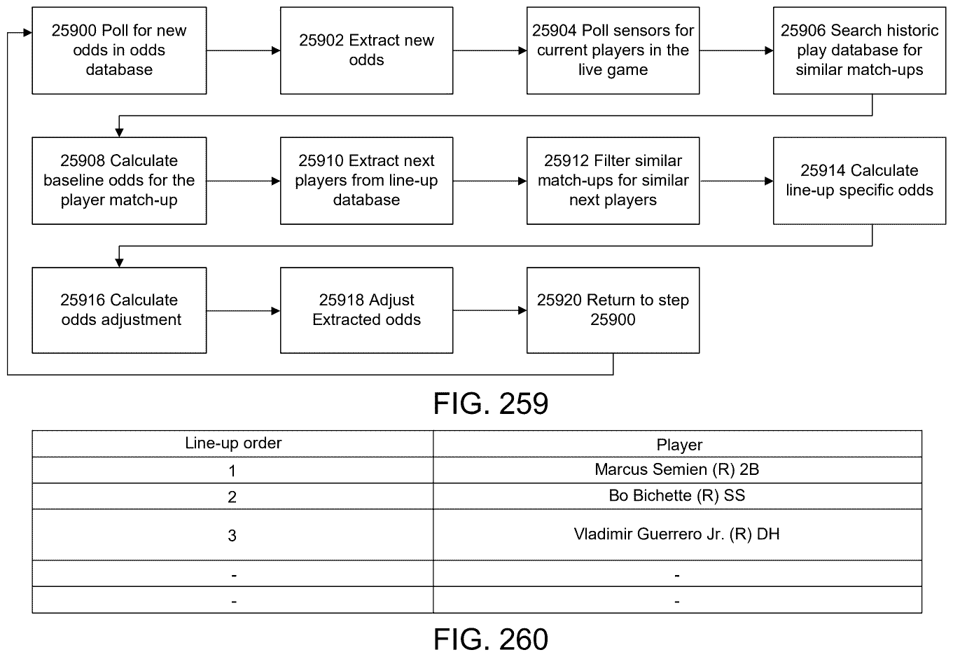

FIG. 259 illustrates an odds adjustment module, according to an embodiment.

FIG. 260 illustrates a lineup database, according to an embodiment.

FIG. 258 displays a system for lineup-based odds adjustment. This system may include a live event 25802, for example, a sporting event such as a football, basketball, baseball, or hockey game, tennis match, golf tournament, eSports, or digital game, etc. The live event 25802 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 25802, such as the score of an American football game or the run line in a baseball game, or a series of actions in the live event 25802. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live event 25802 in the future. Sportsbooks need to offer payment processing services to cash out customers which can be done at kiosks at the live event 25802 or at another location.

Further, embodiments may include a plurality of sensors 25804 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 25804 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 25806 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 25806 may be communicatively coupled to a peer-to-peer wagering network 25814, which may perform real-time analysis on the type of play and the result of the play. The cloud 25806 may also be synchronized with game situational data such as the time of the game, the score, location on the field, weather conditions, and the like, which may affect the choice of play utilized. For example, in an exemplary embodiment, the cloud 25806 may not receive data gathered from the sensors 25804 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 25808 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, Fire Wire, Ethernet, Gigabit Ethernet, Fiber Channel, or Thunderbolt buses. In some embodiments, the mobile device 25808 could be an optional component and would be utilized in a situation where a paired wearable device employs the mobile device 25808 for additional memory or computing power or connection to the internet.

Further, embodiments may include a wagering software application or a wagering app 25810, which is a program that enables the user to place bets on individual plays in the live event 25802, streams audio and video from the live event 25802, and features the available wagers from the live event 25802 on the mobile device 25808. The wagering app 25810 allows the user to interact with the wagering network 25814 to place bets and provide payment/receive funds based on wager outcomes.

Further, embodiments may include a mobile device 25808 database 25812 that may store some or all the user's data, the live event 25802, or the user's interaction with the wagering network 25814.

Further, embodiments may include the wagering network 25814, which may perform real-time analysis on the type of play and the result of a play or action. The wagering network 25814 (or the cloud 25806) may also be synchronized with game situational data, such as the time of the game, the score, location on the field, weather conditions, and the like, which may affect the choice of play utilized. For example, in an exemplary embodiment, the wagering network 25814 may not receive data gathered from the sensors 25804 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 25814 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 25816, which may contain data relevant to all users of the wagering network 25814 and may include, but is not limited to, a user ID, a device identifier, a paired device identifier, wagering history, or wallet information for the user. The user database 25816 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 25816 may contain betting lines and search queries. The user database 25816 may be searched based on a search criterion received from the user. Each betting line may include but is not limited to, a plurality of betting attributes such as at least one of the following: the live event 25802, a team, a player, an amount of wager, etc. The user database 25816 may include, but is not limited to, information related to all the users involved in the live event 25802. In one exemplary embodiment, the user database 25816 may include information for generating a user authenticity report and a wagering verification report. Further, the user database 25816 may be used to store user statistics like, but not limited to, the retention period for a particular user, frequency of wagers placed by a particular user, the average amount of wager placed by each user, etc.

Further, embodiments may include a historical plays database 25818 that may contain play data for the type of sport being played in the live event 25802. For example, in American Football, for optimal odds calculation, the historical play data may include metadata about the historical plays, such as time, location, weather, previous plays, opponent, physiological data, etc.

Further, embodiments may utilize an odds database 25820—that contains the odds calculated by an odds calculation module 25822—to display the odds on the user's mobile device 25808 and take bets from the user through the mobile device 25808 wagering app 25810.

Further, embodiments may include the odds calculation module 25822, which may utilize historical play data to calculate odds for in-play wagers.

Further, embodiments may include an odds adjustment module 25824, which may adjust the odds created by the odds calculation module 25822 based on the lineup of players. For example, if the upcoming batter in a baseball game is a strong hitter, it may be more likely than average that the current batter is walked or hits a single to fill the bases for the upcoming strong hitter. The odds adjustment module 25824 may include more players than just those in the next play in the adjustment calculation.

Further, embodiments may include a lineup database 25826, which may contain the order of players in the current lineup scheduled to play in the live event 25802. For example, if the live event 25802 is a baseball game, the lineup database 25826 may contain the batting order for each team.

FIG. 259 displays the odds adjustment module 25824. The process may begin with the odds adjustment module 25824 polling, at step 25900, for new odds in the odds database 25820. These odds may be generated by the odds calculation module 25822. The odds adjustment module 25824 may extract, at step 25902, the new odds from the odds database 25820. The odds adjustment module 25824 may poll, at step 25904, the sensors 25804 for data on the current players in the live event 25802. This data may also be obtained from the lineup database 25826. The odds adjustment module 25824 may search, at step 25906, the historic play database 25818 for similar matchups. Similar matchups may not be the same players. For example, only the batter and pitcher in baseball may be relevant to determining if a matchup is similar. The presence or absence of runners on base may also be used to determine if a matchup is similar. The characteristics and position of the runners on base may also be used to determine if a matchup is similar. For example, having a runner on first base may be a similar situation. Matchups may be different if the runner on first base is a threat to steal second base, as that often impacts the approach and effectiveness of the pitcher. A matchup may be similar if the players are not identical but have similar stats. For example, Marcus Semien batting against a right-handed pitcher may be similar to a matchup with Marcus Semien batting against a different right-handed pitcher with the same, or close to the same, pitching profile. The criteria for a matchup to be similar may be static or dynamic and may be set by an administrator or another module. The criteria for a matchup to be similar may be expanded to capture a certain threshold of results. For example, if there are only 30 past examples of the same batter and pitcher, then the criteria for similarity may be expanded until at least 1000 matchups are found. The odds adjustment module 25824 may calculate, at step 25908, the baseline odds for the player matchup by the percentage that each outcome occurs. For example, if 1000 similar matchups are found in the historic play database 25818 and of those 1000 matchups, 600 are strikeouts, 300 are hits, 100 are walks, the baseline odds for each outcome may be 60% for a strikeout, 30% for a hit, and 10% for a walk. Hits may be further broken down into singles, doubles, home runs, etc. The odds adjustment module 25824 may extract, at step 25910, the next players from the line-up database 25826. The odds adjustment module 25824 may filter the similar matchups in the historic play database 25818, at step 25912, for matchups followed by similar next players from the line-up database 25826. For example, if the next batter is Bo Bichette, the odds adjustment module 25824 may filter the similar matchups for only those matchups followed by Bo Bichette or a similar player. Similar next players may not be the same players. For example, a next batter may be similar to another batter with the same, or close to the same, batting average. The criteria for a player to be similar may be static or dynamic and may be set by an administrator or another module. The criteria for a player to be similar may be expanded to capture a certain threshold of results. For example, if out of all 1000 similar matchups, only 5 had Bo Bichette as the next batter, then the criteria for similarity may be expanded until at least 100 matchups are found. The odds adjustment module 25824 may calculate, at step 25914, the lineup specific odds for the player matchup by the percentage that each outcome occurs. For example, if 100 similar matchups with similar next players are found in the historic play database 25818 and of those 100 matchups, 60 are strikeouts, 20 are hits, 20 are walks, the lineup-specific odds for each outcome may be 60% for a strikeout, 20% for a hit, and 20% for a walk. Hits may be further broken down into singles, doubles, home runs, etc. The odds adjustment module 25824 may calculate, at step 25916, the odds adjustment amounts for each outcome by comparing the baseline matchup odds to the lineup specific matchup odds. For example, if the baseline odds are 60% for a strikeout, 30% for a hit, and 10% for a walk with the lineup-specific odds at 60% for a strikeout, 20% for a hit, and 20% for a walk, the adjustment for the strikeout odds may be 0%, the adjustment for hit odds may be −10%, and the adjustment for walk odds may be +10%. These adjustments may reflect that the current batter is more concerned with loading the bases for the next batter than attempting to get a strong hit. The odds adjustment module 25824 may adjust, at step 25918, the extracted odds based on the calculated odds adjustment. Note that the extracted odds may be the odds for the current play of the live event 25802 and not the baseline odds for the matchup. The calculated adjustment for each outcome may adjust the odds and, if necessary, be normalized so that all the odds combined are still 100% or under 100%. For example, if the extracted odds are 50% for a strikeout, 40% for a hit, and 10% for a walk with the adjustment for each outcome at 0%, −10% and +10% respectively, the adjusted odds may be 50% for a strikeout, 30% for a hit, and 20% for a walk. Odds may also be adjusted by a percentage increase instead of a flat increase. The odds adjustment module 25824 may return, at step 25920, to step 25900.

FIG. 260 displays the lineup database 25826. The lineup database 25826 may contain the player lineup for the current live event 25802. Lineup data may include a lineup order number and the player name or other identifier. The database may also contain player stats, or other metrics, that could be used by the odds adjustment module 25824 to find similar players.

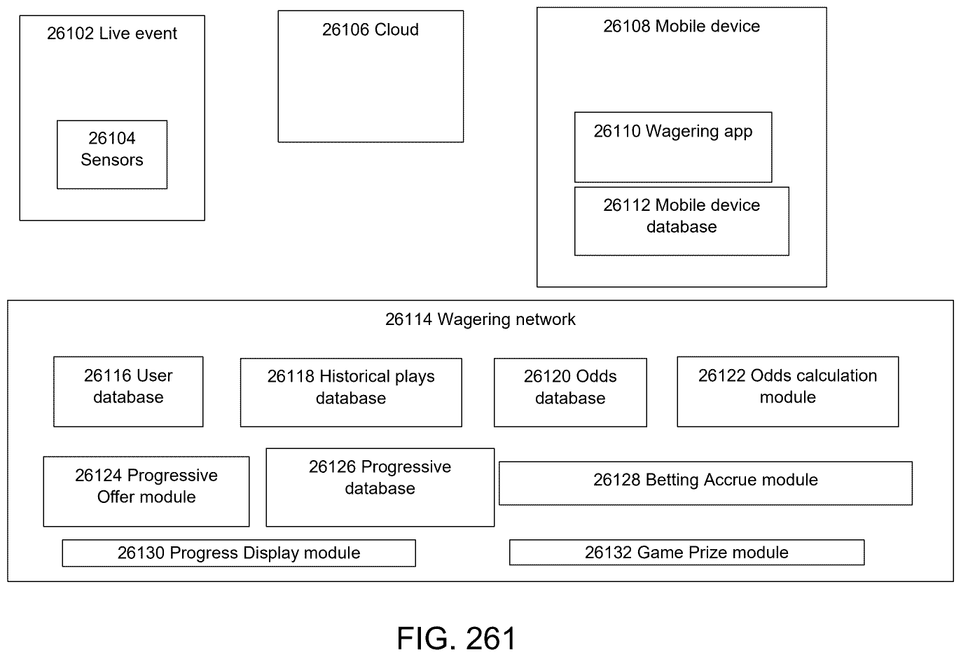

FIG. 261: illustrates a system for displaying individual jackpots to increase user engagement, according to an embodiment.

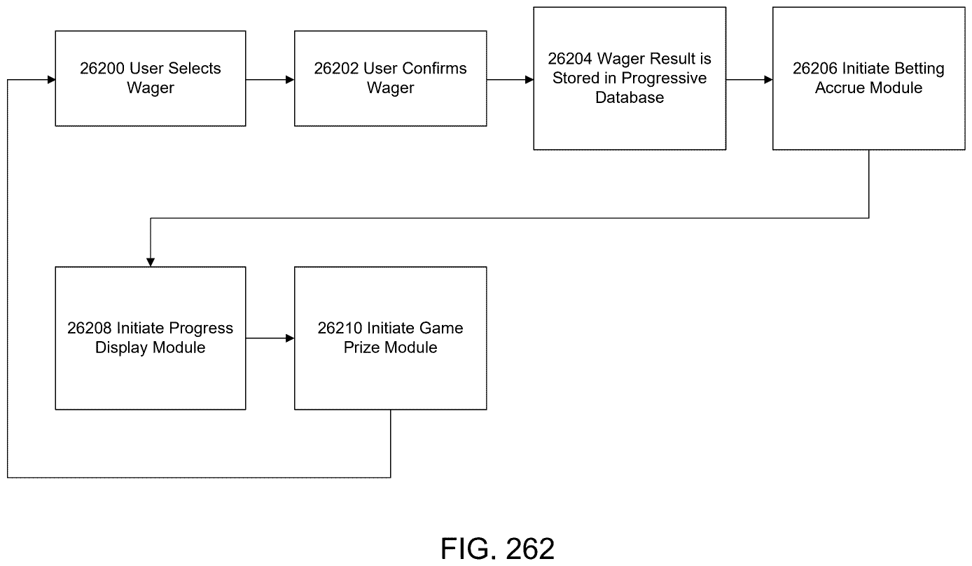

FIG. 262: illustrates a progressive offer module, according to an embodiment.

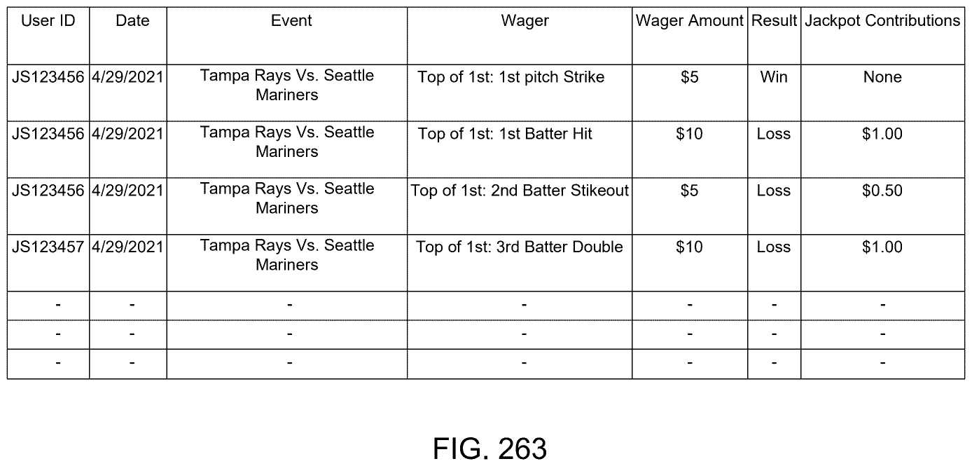

FIG. 263: illustrates a progressive database, according to an embodiment.

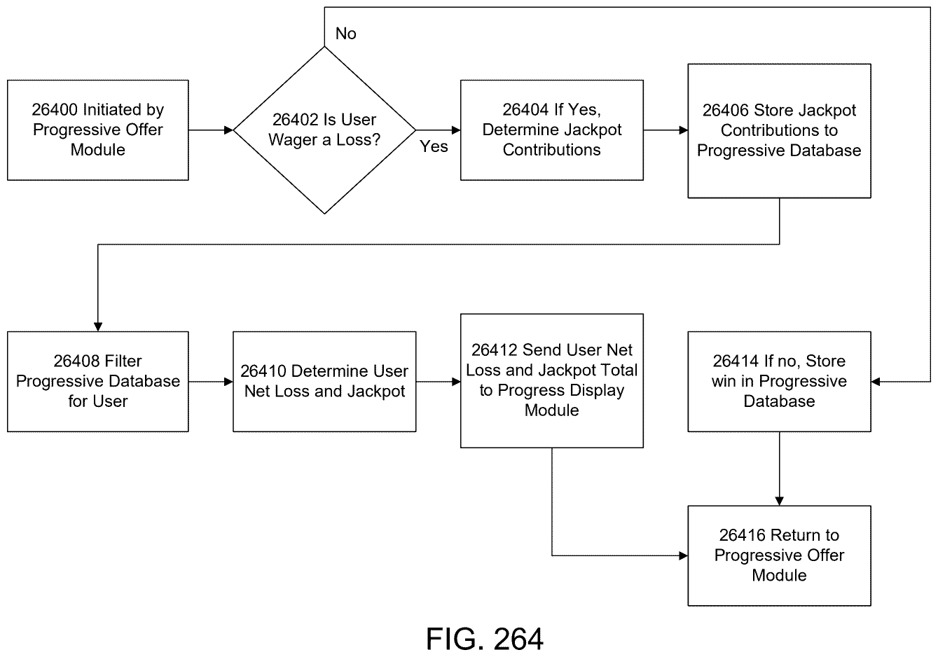

FIG. 264: illustrates a betting accrue module, according to an embodiment.

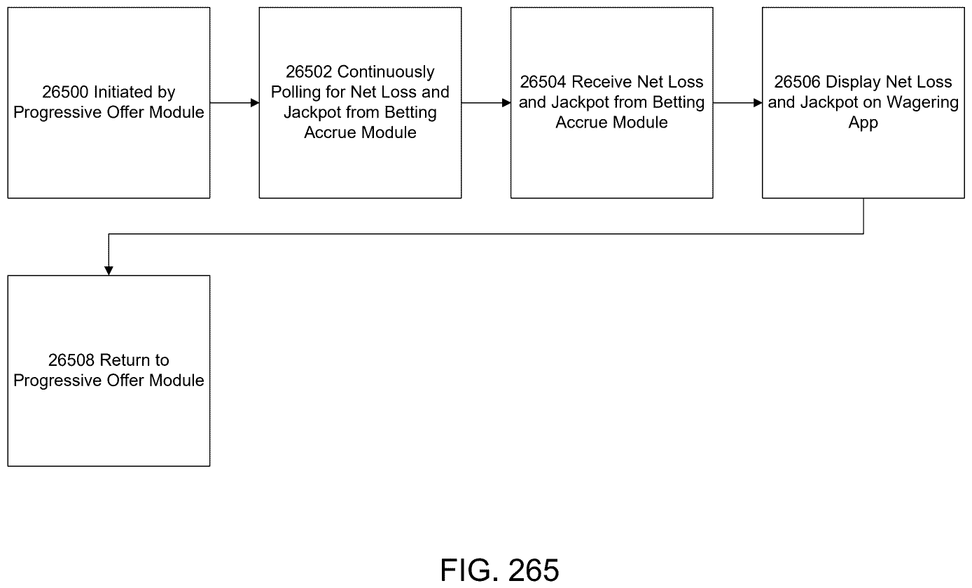

FIG. 265: illustrates a progress display module, according to an embodiment.

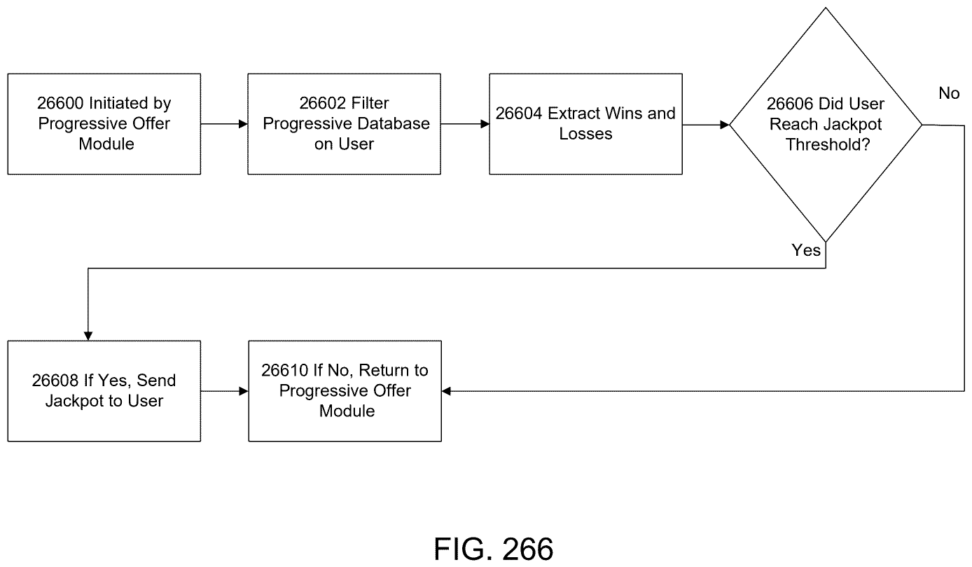

FIG. 266: illustrates a game prize module, according to an embodiment.

FIG. 261 displays a system for displaying individual jackpots to increase user engagement. This system may include a live event 26102, for example, a sporting event such as a football, basketball, baseball, or hockey game, tennis match, golf tournament, eSports or digital game, etc. The live event 26102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 26102, such as the score of an American football game or the run line in a baseball game, or a series of actions in the live event 26102. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live event 26102 in the future. Sportsbooks need to offer payment processing services to cash out customers which can be done at kiosks at the live event 26102 or at another location.

Further, embodiments may include a plurality of sensors 26104 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 26104 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 26106 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 26106 may be communicatively coupled to a peer-to-peer wagering network 26114, which may perform real-time analysis on the type of play and the result of the play. The cloud 26106 may also be synchronized with game situational data such as the time of the game, the score, location on the field, weather conditions, and the like, which may affect the choice of play utilized. For example, in an exemplary embodiment, the cloud 26106 may not receive data gathered from the sensors 26104 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 26108 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 26108 could be an optional component and would be utilized in a situation where a paired wearable device employs the mobile device 26108 for additional memory or computing power or connection to the internet.

Further, embodiments may include a wagering software application or a wagering app 26110, which is a program that enables the user to place bets on individual plays in the live event 26102, streams audio and video from the live event 26102, and features the available wagers from the live event 26102 on the mobile device 26108. The wagering app 26110 allows the user to interact with the wagering network 26114 to place bets and provide payment/receive funds based on wager outcomes.

Further, embodiments may include a mobile device database 26112 that may store some or all the user's data, the live event 26102, or the user's interaction with the wagering network 26114.

Further, embodiments may include the wagering network 26114, which may perform real-time analysis on the type of play and the result of a play or action. The wagering network 26114 (or the cloud 26106) may also be synchronized with game situational data, such as the time of the game, the score, location on the field, weather conditions, and the like, which may affect the choice of play utilized. For example, in an exemplary embodiment, the wagering network 26114 may not receive data gathered from the sensors 26104 and may, instead, receive data from an alternative data feed, such as SportsRadar®. This data may be provided substantially immediately following the completion of any play, and may be compared with a variety of team data and league data based on a variety of elements, including the current down, possession, score, time, team, and so forth, as described in various exemplary embodiments herein. The wagering network 26114 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 26116, which may contain data relevant to all users of the wagering network 26114 and may include, but is not limited to, a user ID, a device identifier, a paired device identifier, wagering history, or wallet information for the user. The user database 26116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 26116 may contain betting lines and search queries. The user database 26116 may be searched based on a search criterion received from the user. Each betting line may include, but is not limited to, a plurality of betting attributes such as at least one of the live event 26102, a team, a player, an amount of wager, etc. The user database 26116 may include, but is not limited to, information related to all the users involved in the live event 26102. In one exemplary embodiment, the user database 26116 may include information for generating a user authenticity report and a wagering verification report. Further, the user database 26116 may be used to store user statistics like, but not limited to, the retention period for a particular user, frequency of wagers placed by a particular user, the average amount of wager placed by each user, etc.

Further, embodiments may include a historical plays database 26118 that may contain play data for the type of sport being played in the live event 26102. For example, in American Football, for optimal odds calculation, the historical play data may include metadata about the historical plays, such as time, location, weather, previous plays, opponent, physiological data, etc. Further, embodiments may utilize an odds database 26120—that contains the odds calculated by an odds calculation module 26122—to display the odds on the user's mobile device 26108 and take bets from the user through the mobile device wagering app 26110.

Further, embodiments may include the odds calculation module 26122, which utilizes historical play data to calculate odds for in-play wagers.

Further, embodiments may include a progressive offer module 26124, which begins with the user selecting and confirming a wager on the wagering app 26110. Next, the progressive offer module 26124 may store the results of the wager in the progressive database 26126. The progressive offer module 26124 may then initiate the betting accrue module 26128. The betting accrue module 26128 may determine if the user's wager was a loss and if it was then the betting accrue module 26128 may determine the jackpot contributions. The betting accrue module 26128 may store the jackpot contributions in the progressive database 26126 and may also filter the progressive database 26126 for the user. Next, the betting accrue module 26128 may determine the user's net loss and current total jackpot contributions. If it is determined that the user's wager was not a loss, then the betting accrue module 26128 may store the win in the progressive database 26126 and may return to the progressive offer module 26124. The progressive offer module 26124 may then initiate the progress display module 26130. The progress display module 26130 may continuously poll for the net loss and total jackpot contributions from the betting accrue module 26128. Next, the progress display module 26130 may receive the net loss and total jackpot contributions from the betting accrue module 26128. The progress display module 26130 may then display the net loss and total jackpot contributions on the wagering app 26110. The progress display module 26130 may then return to the progressive offer module 26124. The progressive offer module 26124 may initiate the game prize module 26132. The game prize module 26132 may filter the progressive database 26126 and extract the wins and losses of the user. The game prize module 26132 may determine that the user reached the jackpot threshold and if so, may send the jackpot to the user. The game prize module 26132 may return to the progressive offer module 26124 after the jackpot is sent to the user or if the user failed to reach the jackpot threshold.

Further, embodiments may include a progressive database 26126 that may contain the wagers placed by a user during the progressive offer module 26124 and the results and the jackpot contributions determined during the process described in the betting accrue module 26128. The progressive database 26126 may contain user IDs, such as JS123456, dates, such as Apr. 29, 2021, events, such as the Tampa Rays vs. Seattle Mariners, wagers, such as the first pitch of the game will result in a strike, wager amounts, such as $5, results, such as a win, or jackpot contributions which may be determined by the betting accrue module 26128 if the wager resulted in a loss.

Further, embodiments may include a betting accrue module 26128, which may determine if the user's wager was a loss. If the user's wager was a loss, then the betting accrue module 26128 may determine the jackpot contributions. For example, there may be a percentage of the wagered amount, such as 10% of the lost wager, sent to a jackpot that the user has an opportunity to win back. This may increase user engagement by allowing the user to potentially recoup a portion of their losses. In some embodiments, the user may accrue points instead of a portion of the lost wager. For example, the user may accumulate one point for every one dollar lost in a wager. The betting accrue module 26128 may then store the jackpot contributions in the progressive database 26126. The betting accrue module 26128 may filter the progressive database 26126 for the user and determine the user's net loss and current total jackpot contributions. The betting accrue module 26128 may determine the net loss of a given user by filtering the progressive database 26126 for user losses, total amounts wagered by the user, and total jackpot contributions. In some embodiments, the total jackpot contributions may be points accrued by the user. The betting accrue module 26128 may send the user's net loss and current total jackpot contributions to the progress display module 26130. If it is determined that the user's wager was not a loss, then the betting accrue module 26128 may store the win in the progressive database 26126 and return to the progressive offer module 26124.

Further, embodiments may include a progress display module 26130, which may continuously poll for the user's net loss and total jackpot contributions from the betting accrue module 26128. For example, the progress display module 26130 may poll for the user's net loss and jackpot contributions from the betting accrue module 26128 and may receive a message like, “User ID JS123456 has a net loss of $25 and a total of $2.50 contributed to the jackpot.” In some embodiments, the progress display module 26130 may poll for the user's net loss amounts and the total points accrued. The progress display module 26130 may then receive the net loss and total jackpot contributions from the betting accrue module 26128 as shown above. The progress display module 26130 may then display the net loss and total jackpot contributions on the wagering app 26110. For example, for the user ID JS123456, the progress display module 26130 may display a net loss of $25 and jackpot contributions of $2.50 on the wagering app's 26110 user interface, informing the user of their current losses and how much they can potentially win back if they win the jackpot. The progress display module 26130 may then return to the progressive offer module 26124.

Further, embodiments may include a game prize module 26132, which may filter the progressive database 26126 for the user. The game prize module 26132 may extract the user's wins and losses. The game prize module 26132 may then determine if the user has reached the jackpot threshold. For example, a threshold may require that the user win a consecutive number of wagers, such as ten wagers, to secure the jackpot contributions. In some embodiments, the user may need to win a consecutive number of wagers within a certain time, such as ten wagers within one hour. In some embodiments, the user may need to win a consecutive number of wagers during one event, such as ten wagers during the Tampa Rays vs. Seattle Mariners event. In some embodiments, if the system is using a point system, the user may need to reach a specific number of points within a given time during a certain event or gain a certain number of points consecutively within a certain time, such as the user needs to accrue 100 points consecutively for ten wagers within one hour. If it is determined that the user reached the jackpot threshold, then the game prize module 26132 may send the jackpot to the user. For example, if the user ID JS123456 passed the threshold of winning ten wagers consecutively, then they may win the $2.50 jackpot. The game prize module 26132 may return to the progressive offer module 26124 after the jackpot is sent to the user or if the user did not reach the jackpot.

FIG. 262 displays the progressive offer module 26124. The process begins with the user selecting, at step 26200, a wager on the wagering app 26110. For example, the user selects a wager on the wagering app 26110, such as the first pitch in the Tampa Rays vs. Seattle Mariners event will be a strike for $5. The user may confirm, at step 26202, the wager on the wagering app 26110. For example, the user may confirm a $5 wager on the result of the first pitch being a strike in the Tampa Rays vs. Seattle Mariners event. The progressive offer module 26124 may store, at step 26204, the results of the wager in the progressive database 26126. For example, the progressive offer module 26124 may store user IDs, such as JS123456, dates, such as Apr. 29, 2021, events, such as Tampa Rays vs. Seattle Mariners, wagers, such as the first pitch, will be a strike, wager amounts, such as $5, and potential results, such as a win. The progressive offer module 26124 may initiate, at step 26206, the betting accrue module 26128. For example, the betting accrue module 26128 may determine if the user's wager was a loss and if so, the betting accrue module 26128 may determine the jackpot contributions. There may be a percentage of the wagered amount sent to a jackpot that the user may have an opportunity to win, thereby potentially increasing user engagement and allowing the user to possibly recoup a portion of their losses, such as 10% of the lost amount wagered. In some embodiments, the user may accrue points instead of a portion of lost wagered amounts. For example, the user may accumulate one point for every one dollar lost in a wager. The betting accrue module 26128 may store the jackpot contributions in the progressive database 26126. The betting accrue module 26128 may filter the progressive database 26126 for the user's net loss and current total jackpot contributions. For example, the betting accrue module 26128 may determine the net loss for a given user by filtering the progressive database 26126 for user losses, total amounts wagered by the user, and total jackpot contributions. In some embodiments, the total jackpot contributions may be points accrued by the user. The betting accrue module 26128 may send the user's net loss and current total jackpot contributions to the progress display module 26130. If the user's wager was not a loss, then the betting accrue module 26128 may store the win in the progressive database 26126 and returns to the progressive offer module 26124. The progressive offer module 26124 may initiate, at step 26208, the progress display module 26130. The progress display module 26130 may continuously poll for the user's net loss and total jackpot contributions from the betting accrue module 26128. For example, the progress display module 26130 may poll to receive the user's net loss and jackpot contributions from the betting accrue module 26128, and receive a message like, “User ID JS123456 has a net loss of $25 and a total of $2.50 contributed to the jackpot.” In some embodiments, the progress display module 26130 may be polling for the net loss amounts and the total points accrued by a user. The progress display module 26130 may receive the net loss and total jackpot contributions from the betting accrue module 26128 as shown above. The progress display module 26130 may display the net loss and total jackpot contributions on the wagering app 26110. For example, for the user ID JS123456, the progress display module 26130 may display a net loss of $25 and jackpot contributions of $2.50 on the wagering app's 26110 user interface, informing the user of their current losses and how much they can potentially win back by securing the jackpot. The progress display module 26130 may then return to the progressive offer module 26124. The progressive offer module 26124 may initiate, at step 26210, the game prize module 26132. The game prize module 26132 may filter the progressive database 26126 for the user. The game prize module 26132 may extract the user's wins and losses. The game prize module 26132 may then determine if the user has reached the jackpot threshold. For example, a threshold may require that the user win a consecutive number of wagers, such as ten wagers, to secure the jackpot contributions. In some embodiments, the user may need to win a consecutive number of wagers within a certain time, such as ten wagers within one hour. In some embodiments, the user may need to win a consecutive number of wagers during one event, such as ten wagers during the Tampa Rays vs. Seattle Mariners event. In some embodiments, if the system is using a point system, the user may need to reach a specific number of points within a given time during a certain event or gain a certain number of points consecutively within a certain time, such as the user needs to accrue 100 points consecutively for ten wagers within one hour. If it is determined that the user reached the jackpot threshold, then the game prize module 26132 may send the jackpot to the user. For example, if the user ID JS123456 passed the threshold of winning ten wagers consecutively, then they may win the $2.50 jackpot. The game prize module 26132 may return to the progressive offer module 26124 after the jackpot is sent to the user or if the user did not reach the jackpot.

FIG. 263 displays the progressive database 26126. The progressive database 26126 may contain the wagers placed by a user during the progressive offer module 26124 and the results and the jackpot contributions determined during the process described in the betting accrue module 26128. The progressive database 26126 may contain user IDs, such as JS123456, dates, such as Apr. 29, 2021, events, such as the Tampa Rays vs. Seattle Mariners, wagers, such as the first pitch of the game will result in a strike, wager amounts, such as $5, results, such as a win, or the jackpot contributions which may be determined by the betting accrue module 26128 if the wager resulted in a loss. In some embodiments, the jackpot contributions may be a percentage of the wagered amount, such as 10% of the lost amount wagered sent to a jackpot that the user may have an opportunity to win, thereby potentially increasing user engagement and allowing the user to possibly recoup a portion of their losses. In some embodiments, the user may accrue points instead of a portion of lost wagered amounts. For example, a user may accumulate one point for every one dollar lost in a wager. In some embodiments, the progressive database 26126 may contain the threshold that the user needs to exceed to win the jackpot contributions. For example, a threshold may require the user win a consecutive number of wagers, such as ten wagers, to win the jackpot contributions. In some embodiments, the user may need to win a consecutive number of wagers within a specific time, such as ten wagers within one hour. In some embodiments, the user may need to win a certain number of wagers consecutively during one event, such as ten wagers during the Tampa Rays vs. Seattle Mariners event. In some embodiments, if the system is using a point system, the user may need to reach a certain number of points within a given time, during a certain event, or gain a certain number of points consecutively within a certain time, such as the user needs to accrue 100 points consecutively for ten wagers within one hour.

FIG. 264 displays the betting accrue module 26128. The process begins with the betting accrue module 26128 being initiated, at step 26400, by the progressive offer module 26124. The betting accrue module 26128 may determine, at step 26402, if the user's wager was a loss. If the wager was not a loss the betting accrue module 26128 may skip to step 26414 otherwise it may proceed to step 26404. The betting accrue module 26128 may receive the result of a user's wager such as a win, a push-which is considered the same as not placing a bet and results in the amount wagered being returned to the user's account—or a loss. If the user's wager was a loss, then the betting accrue module 26128 may determine, at step 26404, the jackpot contributions. For example, there may be a percentage of the wagered amount, such as 10%, sent to a jackpot that the user may have an opportunity to win back thereby potentially increasing user engagement and allowing the user to possibly recoup a portion of their losses. In some embodiments, the user may accrue points instead of a portion of lost wagered amounts. For example, the user may accumulate one point for every one dollar lost in a wager. The betting accrue module 26128 may store, at step 26406, the jackpot contributions in the progressive database 26126. A percentage of the wagered amount may be stored in the progressive database 26126 to record the contribution to the jackpot. In some embodiments, the jackpot contributions may be a percentage of the user's lost wagered amount. In some embodiments, the jackpot contributions may be a point systemin which points may be accumulated in the jackpot. The user may accrue points by losing wagers and may, for example, gain one point for every dollar lost. The betting accrue module 26128 may filter, at step 26408, the progressive database 26126 for the user. For example, the betting accrue module 26128 may filter the progressive database 26126 for the user ID JS123456, to see their betting history. The betting accrue module 26128 may determine, at step 26410, the user's net loss and current total jackpot contributions. For example, the betting accrue module 26128 may determine the net loss of a given user by filtering the progressive database 26126 for user losses, total amounts wagered by the user, and total jackpot contributions. In some embodiments, the total jackpot contributions may be points accrued by the user. The betting accrue module 26128 may send, at step 26412, the user's net loss and current total jackpot contributions to the progress display module 26130. For example, for the user ID JS123456, the total net loss may be $25, and total jackpot contributions may be $2.50. These totals may be sent to the progress display module 26130 to be displayed to the user through the wagering app 26110. If the user's wager was not a loss, then the betting accrue module 26128 may store the win, at step 26414, in the progressive database 26126. For example, if a user won a wager, the result of “won” may be stored in the results column of the progressive database 26126. The betting accrue module 26128 may return to the progressive offer module 26124 at step 26416.

FIG. 265 displays the progress display module 26130. The process begins with the progress display module 26130 being initiated, at step 26500, by the progressive offer module 26124. The progress display module 26130 may continuously poll, at step 26502, for the net loss and total jackpot contributions from the betting accrue module 26128. For example, the progress display module 26130 may poll to receive the user's net loss and jackpot contributions from the betting accrue module 26128, and receive a message like, “User ID JS123456 has a net loss of $25 and a total of $2.50 contributed to the jackpot.” In some embodiments, the progress display module 26130 may poll for the net loss amounts and the total points accrued by a user. The progress display module 26130 may receive, at step 26504, the net loss and total jackpot contributions from the betting accrue module 26128 as shown above. The progress display module 26130 may display, at step 26506, the net loss and total jackpot contributions on the wagering app 26110. For example, for the user ID JS123456, the progress display module 26130 may display a net loss of $25 and jackpot contributions of $2.50 on the wagering app's 26110 user interface, informing the user of their current losses and how much they can potentially win back by securing the jackpot. The progress display module 26130 may return, at step 26508, to the progressive offer module 26124.

FIG. 266 Illustrates the game prize module 26132. The process begins with the game prize module 26132 being initiated, at step 26600, by the progressive offer module 26124. The game prize module 26132 may filter, at step 26602, the progressive database 26126 for the user. For example, the game prize module 26132 may filter the progressive database 26126 for user ID JS123456. The game prize module 26132 may extract, at step 26604, the user's wins and losses stored in the progressive database 26126. Then the game prize module 26132 may determine, at step 26606, if the user reached the jackpot eligibility threshold and may proceed to step 26608 or may skip to step 26610 if the threshold was not met. For example, a threshold may require the user needs to win a consecutive number of wagers, such as ten wagers, to win the jackpot contributions. In some embodiments, the user may need to win a consecutive number of wagers within a certain time, such as ten wins within one hour. In some embodiments, the user may need to win a consecutive number of wagers during one event, such as ten wagers during the Tampa Rays vs. Seattle Mariners event. In some embodiments, if the system is using a point system, the user may need to reach a certain number of points within a given time, during a specific event or gain a certain number of points consecutively within a certain time, such as the user needs to accrue 100 points consecutively for ten wagers within an hour. If the user reaches the jackpot eligibility threshold, then the game prize module 26132 may send, at step 26608, the jackpot to the user. For example, if the user ID JS123456 passed the threshold of winning ten wagers consecutively, then they would win the $2.50 in the jackpot. The game prize module 26132 may return, at step 26610, to the progressive offer module 26124 after the user receives the jackpot or previously failed to meet the eligibility threshold as tested in step 26606.

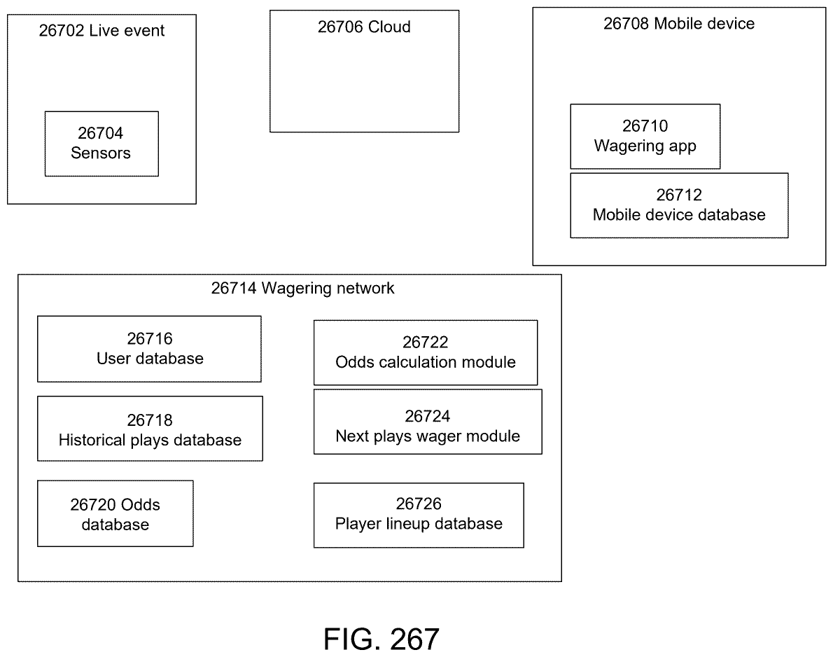

FIG. 267: illustrates a system for an at-bat/per drive wagering, according to an embodiment.

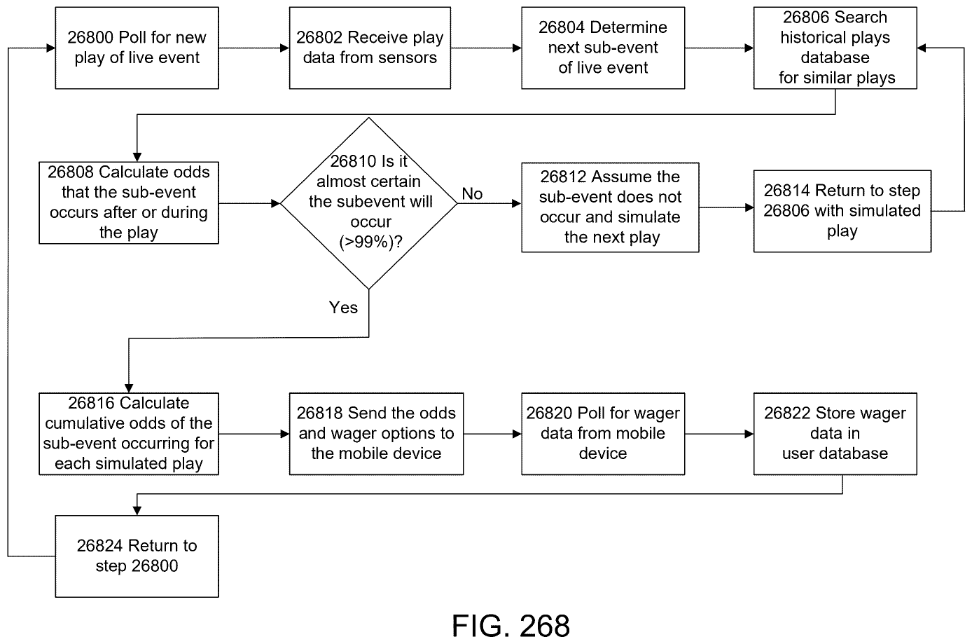

FIG. 268: illustrates a next plays wager module, according to an embodiment.

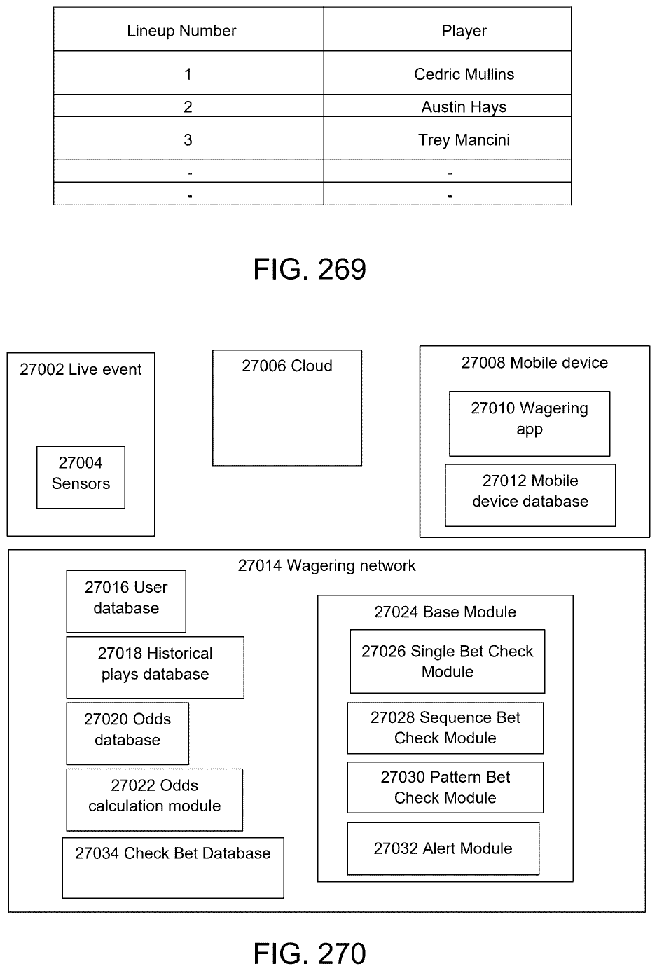

FIG. 269: illustrates a player lineup database, according to an embodiment.

FIG. 267 displays a system for an at-bat/per drive wagering. This system may include a live event 26702, for example, a sporting event such as a football, basketball, baseball, or hockey game, tennis match, golf tournament, eSports, or digital game, etc. The live event 26702 may include some number of actions or plays upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 26702, such as the score of an American football game or the run line in a baseball game, or a series of actions in the live event 26702. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer future bets on live event 26702 in the future. Sportsbooks need to offer payment processing services to cash out customers, which can be done at kiosks at the live event 26702 or at another location.

Further, embodiments may include a plurality of sensors 26704 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 26704 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 26706 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 26706 may be communicatively coupled to a peer-to-peer wagering network 26714, which may perform real-time analysis on the type of play and the result of the play. The cloud 26706 may also be synchronized with game situational data such as the time of the game, the score, location on the field, weather conditions, and the like, which may affect the choice of play utilized. For example, in an exemplary embodiment, the cloud 26706 may not receive data gathered from the sensors 26704 and may, instead, receive data from an alternative data feed, such as Sports Radar®. This data may be compiled substantially immediately following the completion of any play and may be compared with a variety of team data and league data based on various elements, including the current down, possession, score, time, team, and so forth, as described in various exemplary embodiments herein.

Further, embodiments may include a mobile device 26708 such as a computing device, laptop, smartphone, tablet, computer, smart speaker, or I/O devices. I/O devices may be present in the computing device. Input devices may include but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple inputs or output devices such as Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 26708 could be an optional component and would be utilized in a situation where a paired wearable device employs the mobile device 26708 for additional memory or computing power or connection to the internet.

Further, embodiments may include a wagering software application or a wagering app 26710, which is a program that enables the user to place bets on individual plays in the live event 26702, streams audio and video from the live event 26702, and features the available wagers from the live event 26702 on the mobile device 26708. The wagering app 26710 allows the user to interact with the wagering network 26714 to place bets and provide payment/receive funds based on wager outcomes.

Further, embodiments may include a mobile device database 26712 that may store some or all the user's data, the live event 26702, or the user's interaction with the wagering network 26714.

Further, embodiments may include the wagering network 26714, which may perform real-time analysis on the type of play and the result of a play or action. The wagering network 26714 (or the cloud 26706) may also be synchronized with game situational data, such as the time of the game, the score, location on the field, weather conditions, and the like, which may affect the choice of play utilized. For example, in an exemplary embodiment, the wagering network 26714 may not receive data gathered from the sensors 26704 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 26714 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 26716, which may contain data relevant to all users of the wagering network 26714 and may include but is not limited to, a user ID, a device identifier, a paired device identifier, wagering history, or wallet information for the user. The user database 26716 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 26716 may contain betting lines and search queries. The user database 26716 may be searched based on a search criterion received from the user. Each betting line may include but is not limited to, a plurality of betting attributes such as at least one of the live event 26702, a team, a player, an amount of wager, etc. The user database 26716 may include but is not limited to information related to all the users involved in the live event 26702. In one exemplary embodiment, the user database 26716 may include information for generating a user authenticity report and a wagering verification report. Further, the user database 26716 may be used to store user statistics like, but not limited to, the retention period for a particular user, frequency of wagers placed by a particular user, the average amount of wager placed by each user, etc.

Further, embodiments may include a historical plays database 26718 that may contain play data for the type of sport being played in the live event 26702. For example, in American Football, for optimal odds calculation, the historical play data may include metadata about the historical plays, such as time, location, weather, previous plays, opponent, physiological data, etc.

Further, embodiments may utilize an odds database 26720—that contains the odds calculated by an odds calculation module 26722—to display the odds on the user's mobile device 26708 and take bets from the user through the mobile device wagering app 26710.

Further, embodiments may include the odds calculation module 26722, which utilizes historical play data to calculate odds for in-play wagers.

Further, embodiments may include a next plays wager module 26724, which may allow users to place bets on the number of plays that may occur before a sub-event of the live event 26702. A sub-event may be any event that occurs within the live event 26702, such as changing of the inning, switching from offense to defense, scoring points, a timeout is called, the end of the live event 26702, etc. For example, a user may be able to place a wager on the number of plays before the end of a drive-in American Football. Sub-events do not need to be part of the game rules; for example, a user might be able to bet on how may plays before an injury occurs or before a commercial break. The next plays wager module 26724 calculates odds based on data in the historical plays database 26718.

Further, embodiments may include a player lineup database 26726, which may contain the order in which players participate in the live event 26702. For example, in baseball, the order of batters is known ahead of time, with some chance of substitution. This data may be used by the next plays wager module 26724 to determine odds for plays that may happen in the future.

FIG. 268 displays a next plays wager module 26724. The process may begin with the next plays wager module 26724 polling, at step 26800, for a new play of the live event 26702. This data may be obtained from the sensors 26704 at the live event 26702. The next plays wager module 26724, may receive, at step 26802, play data from the sensors 26704 at the live event 26702. Play data may include the details of the current play, such as which players are on the field, the state of the live event 26702, the weather, the previous play, wind vector, the team on offense or defense, etc. The next plays wager module 26724 may determine, at step 26804, the next sub-event of the live event 26702. A sub-event may be, for example, an out in baseball, a 4th down in American football, the end of a subdivision of the live event 26702, such as a quarter, inning, or timeout, etc. The sub-events included may be set by an administrator. Multiple sub-events may be determined simultaneously, for example, the next timeout and the end of the next inning. In this case, multiple iterations of the next plays wager module 26724 may run for each determined sub-event. The next plays wager module 26724, may search, at step 26806, the historical plays database 26718 for similar plays occurring during the live event 26702. A similar play may not have to be an exact match. For example, two plays with the same team and players may be similar even though the weather may differ. An administrator of the system or another module may adjust which plays are considered similar. The next plays wager module 26724, may calculate, at step 26808, odds that the sub-event occurs during or after the play based on the extracted similar plays from the historical plays database 26718. For example, if 100 similar plays are extracted and 27 of those plays resulted in the end of the inning with the other 73 resulting in the inning continuing, the odds for the outcome of the play to be the end of the inning may be calculated to be 27%. The next plays wager module 26724, may determine, at step 26810, if it is almost certain that the sub-event will occur during or after the play. The certainty that a sub-event may occur may be determined by checking if the calculated odds of the sub-event occurring are above 99%. This threshold may be different than 99%, static or dynamic, or set by an administrator or another module. If the threshold is met, the next plays wager module 26724 may skip to step 26816. If the threshold is not met, the next plays wager module 26724, may assume, at step 26812, that the sub-event does not occur and simulate the next play of the live event 26702. For example, if the live event 26702 is a baseball game with the current state of the game in the bottom of the 3rd inning with two outs, the sub-event may be the end of the inning. Assuming the outcome of the current play is a third out, the inning would end. The simulated play may then be based on how the state of the game would have been had there not been a third out. The simulated play may be generated by assuming the most likely outcome that does not result in the sub-event. The next plays wager module 26724, may generate a simulated play for each outcome that does not result in the sub-event. For example, the sub-event is the end of an inning, but a single, double, home run, or walk occurs, causing some alternative outcome to occur instead of the inning ending. These alternatives may each then be used to generate a separate simulated state of the live event 26702. The next plays wager module 26724, may use data in the player lineup database 26726 to predict which players may be part of the next play of the live event 26702. The next plays wager module 26724, may then return, at step 26814, to step 26806 with the simulated play selected. If more than one simulated play is generated in step 26812, each simulated play may simultaneously be selected and run through another iteration of the next plays wager module 26724. The next plays wager module 26724 may select the next simulated play that has not yet had odds calculated. If it is almost certain that the sub-event will occur during or after the play, at step 26810, the next plays wager module 26724 may calculate, at step 26816, the cumulative odds of the sub-event occurring for each simulated play. The cumulative odds may be the odds that a sub-event occurs several plays from the current state of the live event 26702. For example, the live event 26702 may be a baseball game with the current state of the game in the bottom of the 3rd inning, with two outs, and Cedric Mullins at-bat. The sub-event may be the end of the inning and if the outcome of the current play results in a third out, the inning would end. The odds of a third out being the outcome of the current play may be calculated to be 60%. Next, assume the current play does not result in a third out-a 40% chance-causing the next batter in the lineup to be up to bat. The next plays wager module 26724, may then simulate the following play with the next batter in the player lineup database 26726, Austin Hays, at-bat. The odds of a third out being the outcome of the simulated next play may be calculated to be 50%. Finally, the next plays wager module 26724 may then calculate the odds for the inning-ending to occur exactly two batters from the current state of the live event 26702. This is done by taking the odds that the current play does not result in the end of the inning, or 40%, multiplied by the odds that the simulated play does result in the end of the inning, or 50%, arriving at 20%. Note that this calculation may be used to determine the odds of the sub-event occurring 2, 3, 4, etc. plays from the current state of the live event 26702. In baseball, the upcoming batter may be substituted for several plays because the batting lineup is already known. For example, the user may be able to bet on whether Austin Hays or Trey Mancini will bat this inning. Odds may also be calculated for the sub-event occurring in a group of plays. For example, if the game is American football, users may be able to bet if a drive will end in less than four plays, exactly four plays, or more than four plays. The next plays wager module 26724 may send, at step 26818, the odds and wagers for each option to the mobile device 26708. The user may then use the wagering app 26710 on the mobile device 26708 to place a wager. Wager options may be all or a subset of the possible number of plays before the sub-event occurs. For example, the user may wager on 1, 2, 3, or 4+ plays before the next touchdown in an American football game. The odds may be adjusted from the calculated odds to account for factors such as risk and profit. The next plays wager module 26724 may poll, at step 26820, for wager data from the mobile device 26708. This wager data may correspond to a wager being placed by a user. The wager data may also correspond to the wagering window closing. The next plays wager module 26724 may store, at step 26822, the wagering data in the user database 26716. If the wagering data corresponds to the wagering window closing before the user submitted a wager, this step may be skipped. The next plays wager module 26724 may return, at step 26824, to step 26800.

FIG. 269 displays a player lineup database 26726. The player lineup database 26726 may contain data on the order in which players take part in plays of the live event 26702. The player lineup database 26726 may include a player's position in the lineup or lineup number. This lineup number may correspond to the order in which the players may play during the live event 26702. For example, the player lineup number may refer to the batting order in a baseball game. The player lineup database 26726 may include the player's name or another identifier for the player. The player lineup database 26726 may include a different database on game type. For example, in American football, players do not have to appear in each play in order. In this case, the player lineup database 26726 may include the odds that a player will participate in the next play based on historical data.

FIG. 270 illustrates a system for uncommon bet notifications, according to an embodiment.

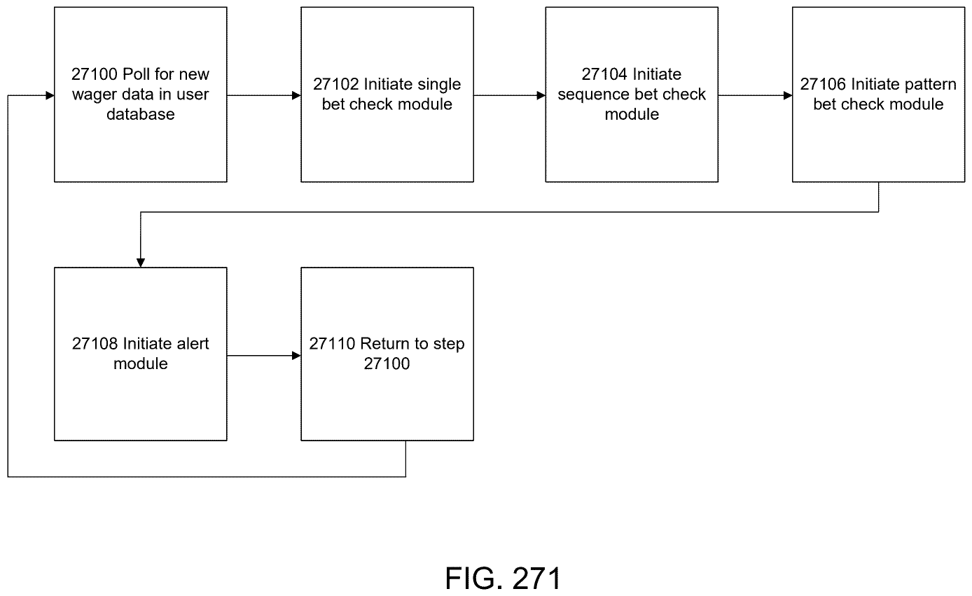

FIG. 271 illustrates a base module, according to an embodiment.

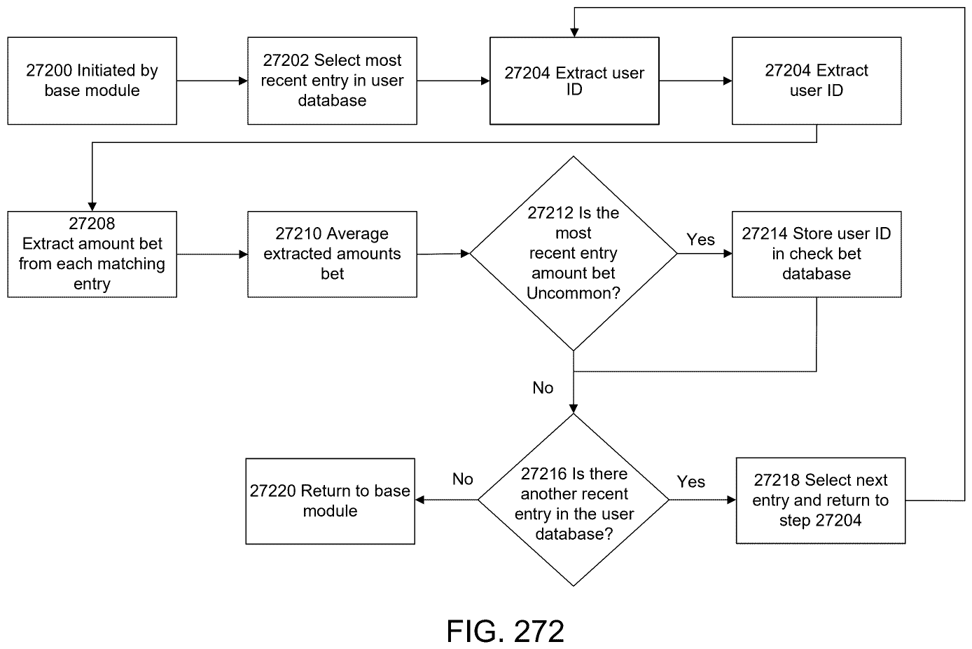

FIG. 272 illustrates a single bet check module, according to an embodiment.

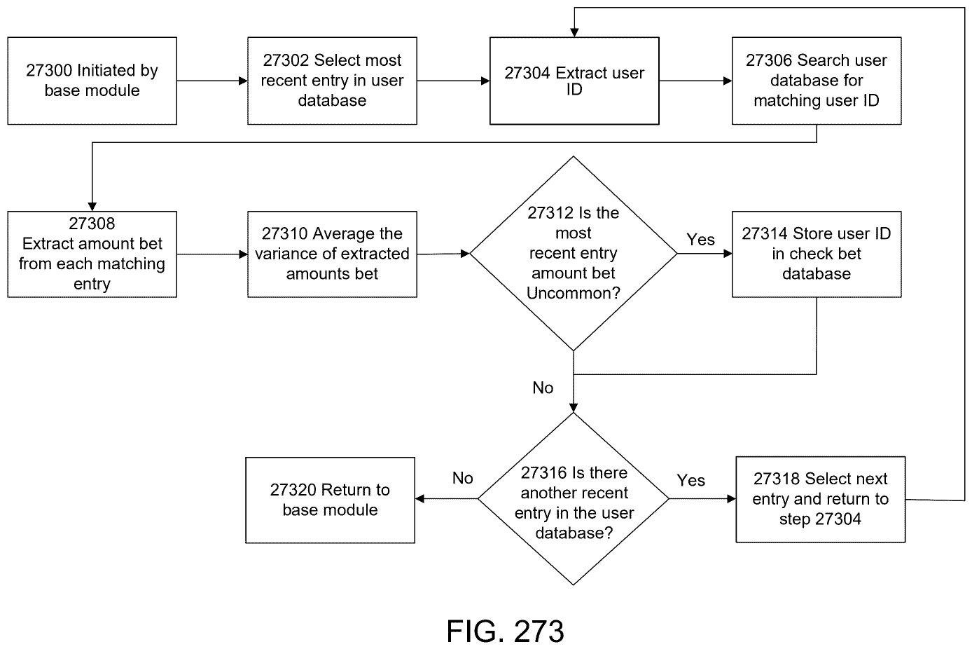

FIG. 273 illustrates a sequence bet check module, according to an embodiment.

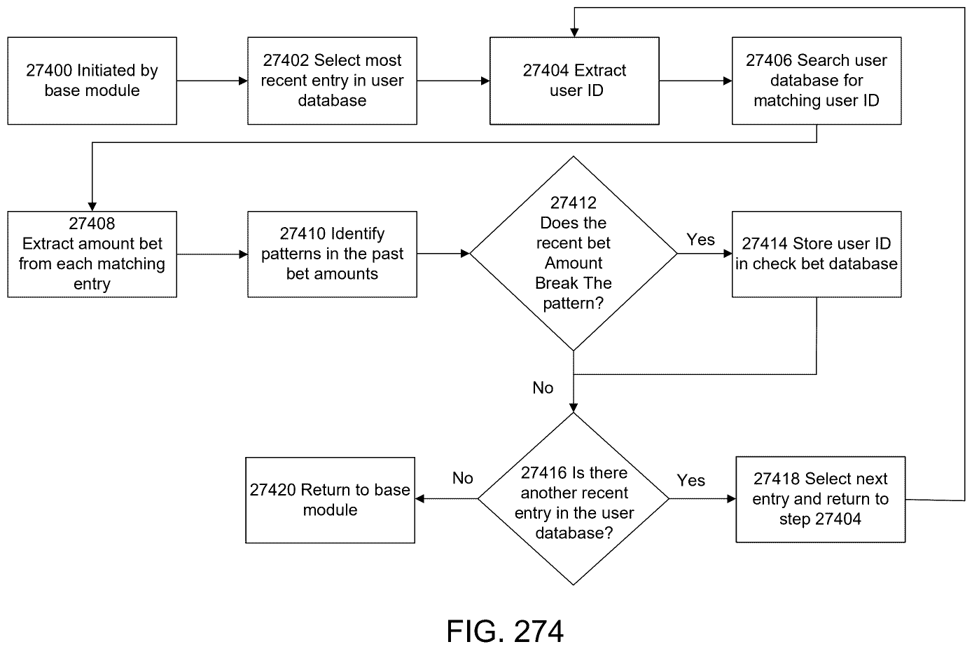

FIG. 274 illustrates a pattern bet check module, according to an embodiment.

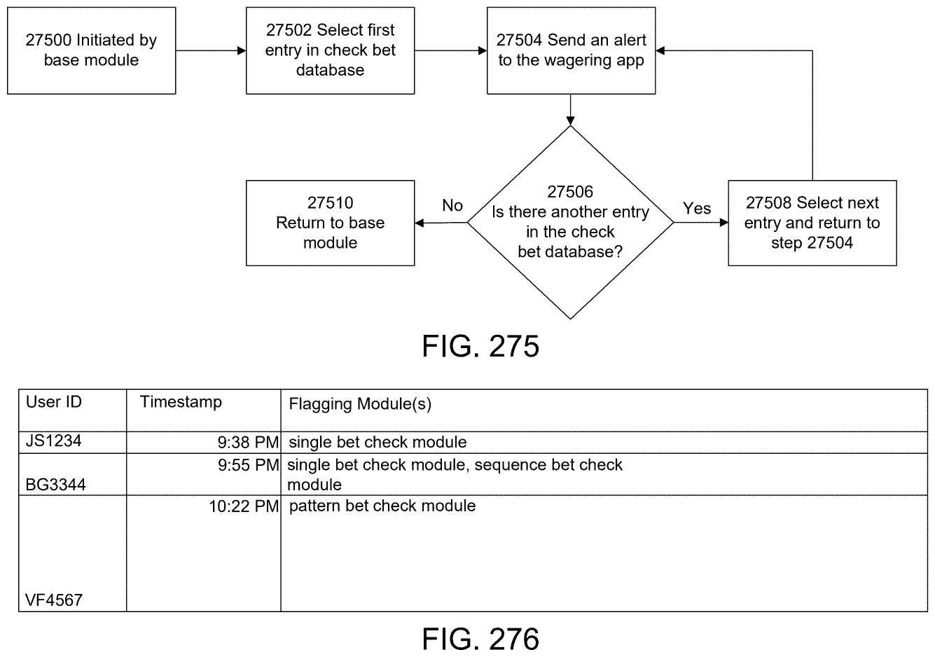

FIG. 275 illustrates an alert module, according to an embodiment.

FIG. 276 illustrates a check bet database, according to an embodiment.

FIG. 270 is a system for uncommon bet notifications. This system may include a live event 27002, for example, a sporting event such as a football game, basketball game, baseball game, hockey game, tennis match, golf tournament, eSports or digital game, etc. The live event 27002 will include some number of actions or plays, upon with a user or bettor or customer can place a bet or wager, typically through an entity called a sportsbook. There are numerous types of wagers the bettor can make, including a straight bet, a money line bet, a bet with a point spread or line that the bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk. This is typically applied to round-robin or other tournaments' styles. There are other types of wagers, including parlays, teasers, and prop bets, that are added games that often allow the user to customize their betting by changing the odds and payouts they receive on a wager. Certain sportsbooks will allow the bettor to buy points, to move the point spread off of the opening line. This will increase the price of the bet, sometimes by increasing the juice, vig, or hold that the sportsbook takes. Another type of wager the bettor can make is an over/under, in which the user bets over or under a total for the live event 27002, such as the score of American football or the run line in baseball, or a series of action in the live event 27002. Sportsbooks have several bets they can handle, a limit of wagers they can take on either side of a bet before they will move the line or odds off of the opening line. Additionally, there are circumstances, such as an injury to an important player such as a listed pitcher, in which a sportsbook, casino, or racino will take an available wager off the board. As the line moves, there becomes an opportunity for a bettor to bet on both sides at different points, spreads to middle, and win both bets. Sportsbooks will often offer bets on portions of games, such as first-half bets and half-time bets. Additionally, the sportsbook can offer futures bets on live events 27002 in the future. Sportsbooks need to offer payment processing services in order to cash out customers. This can be done at kiosks at the live event 27002 or at another location.

Further, embodiments may include a plurality of sensors 27004 that may be used such as motion sensors, temperature sensors, humidity sensors, optical sensors and cameras such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices, etc. Also, the plurality of sensors 27004 may include tracking devices, such as RFID tags, GPS chips, or other such devices embedded on uniforms, in equipment, in the field of play, in the boundaries of the field of play, or on other markers on the field of play. Imaging devices may also be used as tracking devices such as player tracking that provides statistical information through real-time X, Y positioning of players and X, Y, Z positioning of the ball.

Further, embodiments may include a cloud 27006 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, and other communication techniques that are known in the art. The communication network may allow ubiquitous access to shared pools of configurable system resources and higher-level services that can be rapidly provisioned with minimal management effort, often over the internet, and relies on sharing of resources to achieve coherence and economics of scale, like a public utility. In contrast, third-party clouds allow organizations to focus on their core businesses instead of expending resources on computer infrastructure and maintenance. Cloud 27006 may be communicatively coupled to a peer-to-peer wagering network 27014, which may perform real-time analysis on the type of play and the result of the play. The cloud 27006 may also be synchronized with game situational data, such as the time of the game, the score, location on the field, weather conditions, and the like, which may affect the choice of play utilized. For example, in other exemplary embodiments, the cloud 27006 may not receive data gathered from the sensors 27004 and may, instead, receive data from an alternative data feed, such as Sports Radar®. This data may be compiled substantially immediately following the completion of any play, and the data from this feed may be compared with a variety of team data and league data based on a variety of elements, including down, possession, score, time, team, and so forth, as described in various exemplary embodiments herein.

Further, embodiments may include a mobile device 27008 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs by combining some of the inputs and outputs. Some devices allow for facial recognition, which may be utilized as an input for different purposes, including authentication and other commands. Some devices provide for voice recognition and inputs, including, e.g., Microsoft KINECT, SIRI for iPhone by Apple, Google Now, or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality, including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control the I/O devices. The I/O controller may control one or more I/O devices, such as e.g., a keyboard and a pointing device, e.g., a mouse or optical pen. Furthermore, an I/O device may also contain storage and/or an installation medium for the computing device. In still some embodiments, the computing device may include USB connections (not shown) to receive handheld USB storage devices. In further embodiments, an I/O device may be a bridge between the system bus and an external communication bus, e.g., a USB bus, a SCSI bus, a FireWire bus, an Ethernet bus, a Gigabit Ethernet bus, a Fiber Channel bus, or a Thunderbolt bus. In some embodiments, the mobile device 27008 could be an optional component and would be utilized in a situation where a paired wearable device utilizes the mobile device 27008 as additional memory or computing power or connection to the internet.

Further, embodiments may include a wagering software application or a wagering app 27010, which is a program that enables the user to place bets on individual plays in the live event 27002 and display the audio and video from the live event 27002, along with the available wagers on the mobile device 27008. The wagering app 27010 allows the user to interact with the wagering network 27014 to place bets and provide payment/receive funds based on wager outcomes.

Further, embodiments may include a mobile device database 27012 that may store some or all of the user's data, the live event 27002, or the user's interaction with the wagering network 27014.

Further, embodiments may include the wagering network 27014, which may perform real-time analysis on the type of play and the result of a play or action. The wagering network 27014 (or the cloud 27006) may also be synchronized with game situational data, such as the time of the game, the score, location on the field, weather conditions, and the like, which may affect the choice of play utilized. For example, in an exemplary embodiments, the wagering network 27014 may not receive data gathered from the sensors 27004 and may, instead, receive data from an alternative data feed, such as SportsRadar®. This data may be provided substantially immediately following the completion of any play, and the data from this feed may be compared with a variety of team data and league data based on a variety of elements, including down, possession, score, time, team, and so forth, as described in various exemplary embodiments herein. The wagering network 27014 can offer several software as a service managed services such as user interface service, risk management service, compliance, pricing and trading service, IT support of the technology platform, business applications, game configuration, state-based integration, fantasy sports connection, integration to allow the joining of social media, as well as marketing support services that can deliver engaging promotions to the user.

Further, embodiments may include a user database 27016, which may contain data relevant to all users of the wagering network 27014, and which may include a user ID, a device identifier, a paired device identifier, wagering history, and wallet information for the user. The user database 27016 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 27016 may contain betting lines and search queries. The user database 27016 may be searched based on a search criterion received from the user. Each betting line may include a plurality of betting attributes such as at least one of the live event 27002, a team, a player, an amount of wager, etc. The user database 27016 may include information related to all the users involved in the live event 27002. In one exemplary embodiment, the user database 27016 may include information for generating a user authenticity report and a wagering verification report. Further, the user database 27016 may be used to store user statistics like, but not limited to, the retention period for a particular user, frequency of wagers placed by a particular user, the average amount of wager placed by each user, etc.

Further, embodiments may include a historical plays database 27018 that may contain play data for the type of sport being played in the live event 27002. For example, in American Football, for optimal odds calculation, the historical play data may include metadata about the historical plays, such as time, location, weather, previous plays, opponent, physiological data, etc.

Further, embodiments may utilize an odds database 27020 that contains the odds calculated by an odds calculation module 27022 to display the odds on the user's mobile device 27008 and to take bets from the user through the mobile device wagering app 27010.

Further, embodiments may include the odds calculation module 27022, which utilizes historical play data to calculate odds for in-play wagers

Further, embodiments may include a base module 27024, which may initiate a single bet check module 27026, a sequence bet check module 27028, a pattern bet check module 27030, and an alert module 27032.

Further, embodiments may include the single bet check module 27026, which may determine if the amount wagered on a single bet is far outside the usual bet amount for a user.

Further, embodiments may include the sequence bet check module 27028, which may determine if the change in the amount wagered on a sequence of bets is far outside the usual change in the amount wagered from bet to bet made by a user.

Further, embodiments may include the pattern bet check module 27030, which may determine if there is any variance from the normal pattern of betting for a user or any unusual pattern in the betting behavior of a user.

Further, embodiments may include the alert module 27032, which may alert a user of uncommon betting behavior and require the user to verify their bet.

Further, embodiments may include a check bet database 27034, which may contain user IDs of users who have been flagged for uncommon betting behavior by the single bet check module 27026, the sequence bet check module 27028, the pattern bet check module 27030, or any combination of these modules. The contained user IDs may then be used by the alert module 27032 to identify the users that need to be alerted.

FIG. 271 displays the base module 27024. The process may begin with the base module 27024 polling, at step 27100, for new wager data in the user database 27016. A new data event may correspond with a user placing a wager on the live event 27002. The base module 27024 may initiate, at step 27102, the single bet check module 27026, which may determine if a single bet is uncommon because of a large deviation from the average betting amount for a user. The base module 27024 may initiate, at step 27104, the sequence bet check module 27028, which may determine if a single or sequence of bets are uncommon because of a large deviation from the average change in betting amount from bet to bet for a user. The base module 27024 may initiate, at step 27106, the pattern bet check module 27030, which may determine if a single or sequence of bets are uncommon because of a large deviation from a user's normal betting behavior pattern. The base module 27024 may initiate, at step 27108, the alert module 27032, which may alert a user when one or more of their wagers have been flagged as uncommon. The base module 27024 may return, at step 27110, to step 27100.

FIG. 272 illustrates the single bet check module 27026. The process may begin with the single bet check module 27026 being initiated, at step 27200, by the base module 27024. The single bet check module 27026 may select, at step 27202, the most recent entry in the user database 27016. The data within the entry may be the most recently placed bet by a user. The single bet check module 27026 may extract, at step 27204, the user ID of the selected entry. The single bet check module 27026 may search, at step 27206, the user database 27016 for entries with a matching user ID to the extracted user ID. This search may find all bets placed by the user. The search may be limited to a certain time frame, for example, the last year. The single bet check module 27026 may extract, at step 27208, the amount bet from each matching entry. The single bet check module 27026 may average, at step 27210, the extracted amounts bet from each entry. The average may be, for example, a mean, median, mode, or other statistical value that characterizes a common trend of data. The single bet check module 27026 may determine, at step 27212, if the amount bet in the selected entry is uncommon compared to the average betting amounts for the user. For example, if the amount bet is three times as large as the average for that user, it may be uncommon. An uncommon betting amount may also be determined using a different multiplier, for example, twelve times larger. The threshold for which bets are flagged as uncommon may be set by an administrator of the system or another module. For example, user Joe has an average wager amount of $10. A system administrator may set a threshold for an uncommon wager at greater than three times the user's mean average amount. In this example, a threshold for an uncommon wager for user joe would be any wager above $30. An uncommon betting amount may also be determined using statistical concepts such as the variance or standard deviation. If the amount of the bet is not uncommon, the single bet check module 27026 may skip to step 27216. If the amount bet is uncommon, the single bet check module 27026 may store, at step 27214, the user ID in the check bet database 27034. The single bet check module 27026 may also store a timestamp of when the uncommon bet was made or identified. The check bet database 27034 may record that the uncommon bet was flagged by the single bet check module 27026. The single bet check module 27026 may determine, at step 27216, if there is another recent entry in the user database 27016 that has not been checked. Recent may mean that bets from the last play of the live event 27002 are excluded or may refer to a fixed time window. If there is another recent entry in the user database 27016, the single bet check module 27026 may select, at step 27218, the next entry and may return to step 27204. If there is not another recent entry in the user database 27216, The single bet check module 27026 may end at step 27220.

FIG. 273 displays the sequence bet check module 27028. The process may begin with the sequence bet check module 27028 being initiated, at step 27300, by the base module 27024. The sequence bet check module 27028 may select, at step 27302, the most recent entry in the user database 27016. The data within the entry may be the most recently placed bet by a user. The sequence bet check module 27028 may extract, at step 27304, the user ID of the selected entry. The sequence bet check module 27028 may search, at step 27306, the user database 27016 for entries with a matching user ID to the extracted user ID. This search may find all bets placed by the user. The search may be limited to a certain time frame, for example, the last year. The sequence bet check module 27028 may extract, at step 27308, the amount bet from each matching entry. The sequence bet check module 27028 may average, at step 27310, the variance from one bet to the next bet between the extracted amounts bet from each entry to determine the average variance between the user's bets. For example, an entry for a user has a bet amount of $20. The next-in-time entry for the same user has a bet amount of $25. The variance between these two bets is 25% since the first amount of $20 would have to be increased by 25% to be $25. The average may be, for example, a mean, median, mode, or other statistical value that characterizes a common trend of data. The sequence bet check module 27028 may determine, at step 27312, if the amount bet in the selected entry is uncommon compared to the average change in betting amounts for the user for bets in sequence. If the amount bet is three times as large as the average variance between sequential bets for that user, it may be determined to be uncommon. For example, the user's average betting variance is 25%. This means that when a user makes a bet, the next bet will be 25% larger or, inversely, 20% smaller on average. If the most recent amount bet by the user is 75% greater than the last bet the user placed, then the most recent amount bet may be uncommon. An uncommon betting amount may be flagged after a sequence of betting amounts that are uncommon. An uncommon betting amount may also be determined using a different multiplier, for example, twelve times larger. The threshold for which bets are flagged as uncommon may be set by an administrator of the system or another module. For example, user Joe has an average wager amount variance of 30%. The last wager Joc made was $10. A system administrator may set a threshold for an uncommon wager at greater than ten times the user's mean average variance amount. In this example, the threshold for an uncommon wager for user Joe would be any wager that is 300% larger or, inversely, 75% smaller than the last wager placed, $40 or $2.50, respectively. Variance in the positive and negative direction may be evaluated separately. An uncommon betting amount may also be determined using statistical concepts such as the standard deviation. If the amount bet is not uncommon, the sequence bet check module 27028 skips to step 27316. If the amount bet is uncommon, the sequence bet check module 27028 may store, at step 27314, the user ID in the check bet database 27034. The sequence bet check module 27028 may also store a timestamp of when the uncommon bet was made or identified. The check bet database 270134 may record that the uncommon bet was flagged by the sequence bet check module 27028. The sequence bet check module 27028 may determine, at step 27316, if there is another recent entry in the user database 27016 that has not been checked. Recent may mean that bets from the last play of the live event 27002 are excluded or may refer to a fixed time window. If there is another recent entry in the user database 116, the sequence bet check module 27028 may select, at step 27318, the next entry and may return to step 27304. If there is no recent entry in the user database 27016, The sequence bet check module 27028 may return to the base module 27024 at step 27320.

FIG. 274 displays the pattern bet check module 27030. The process may begin with the pattern bet check module 27030 being initiated, at step 27400, by the base module 27024. The pattern bet check module 27030 may select, at step 27402, the most recent entry in the user database 27016. The data within the entry may be the most recently placed bet by a user. The pattern bet check module 27030 may extract, at step 27404, the user ID of the selected entry. The pattern bet check module 27030 may search, at step 27006, the user database 27016 for entries with a matching user ID to the extracted user ID. This may find all bets placed by the user. The search may be limited to a certain time frame, for example, the last year. The pattern bet check module 27030 may extract, at step 27408, the amount of the bet from each matching entry. The pattern bet check module 27030 may identify, at step 27410, a pattern to the betting behavior of the user. For example, the user may usually bet low amounts at the beginning of the live event 27002 and higher amounts later. Other data may be included to better define patterns such as game type, teams, time, results of the previous bet, weather, day of the week, etc. These patterns may be detected using pattern recognition algorithms which may involve artificial intelligence. Further, the pattern bet check module 27030 may evaluate the time when a user makes a wager. For example, if a user always or frequently places a wager shortly before the closing of a wager time window and then makes a wager as soon as a time window for a wager opens, that could be deemed an uncommon wager. Other examples could include an uncommon wager has been placed by a user who places multiple wagers on a single play when they historically only make one wager on a single play, if a user wagers on a number of consecutive plays when they typically wager less frequently, or a user cancels or changes a wager when they historically have not canceled or changed a wager. The pattern bet check module 27030 may look at the patterns of similar users if there is insufficient data on the user. For example, the pattern check module 27030 can look at other users with similar betting habits or bankrolls. Alternatively, the pattern check module 27030 could evaluate a user's betting activity in comparison to known bettors who historically place larger wagers (e.g. “high rollers” or “whales”) to see if there is a correlation between such wagers, which could indicate the sharing of data from the high rollers or whales, or potential hacking or otherwise unauthorized use of data. The pattern bet check module 27030 may also detect patterns that may indicate that a user is using an automated wagering bot, has a gambling problem, has had their account taken by another person, etc. The pattern bet check module 27030 may determine, at step 27412, if the amount bet in the selected entry is uncommon compared to the usual pattern behavior of the user. If the amount bet is larger or smaller by a threshold percentage or value than the expected bet, it may be determined to be uncommon. The expected bet may be estimated based on a user's past betting behavior. For example, user Joc has a history of betting on average 50% larger amounts after each win and 20% smaller amounts after a loss. Joe bet $10 on the last play and lost. Based on Joe's historical behavior, the system calculates an expected next bet of 20% less than $10 or $8. A system administrator may set a threshold for an uncommon wager at five times larger than the expected amount Joe would bet based on Joe's betting pattern. In this example, the threshold for an uncommon wager for user Joe would be any amount above $40. A different percentage or value may be used for the upper and lower threshold. For example, a 400% increase or a 95% decrease may cause a wager amount to be flagged as uncommon. For example, a user who is expected to bet $1000 in a given context based on their past behavior enters a wager amount of $10; it may be flagged as uncommon as the user may have miss entered the number of zeros in their wager amount. An uncommon betting amount may be flagged after a sequence of betting amounts that are uncommon based on the past betting behavior of the user. The threshold for which bets are flagged as uncommon may be set by an administrator of the system or another module. If the amount bet is not uncommon, the pattern bet check module 27030 skips to step 27416. If the amount bet is uncommon, the pattern bet check module 27030 may store, at step 27414, the user ID in the check bet database 27034. The pattern bet check module 27030 may also store a timestamp of when the uncommon bet was made or identified. The check bet database 27034 may record that the uncommon bet was flagged by the pattern bet check module 27030. The pattern bet check module 27030 may determine, at step 27416, if there is another recent entry in the user database 27016 that has not been checked. Recent may mean that bets from the last play of the live event 27002 are excluded or may refer to a fixed time window. If there is another recent entry in the user database 116, the pattern bet check module 27030 may select, at step 27418, the next entry and may return to step 27404. If there is no recent entry in the user database 27016, The pattern bet check module 27030 may return to the base module 27024 at step 27420.

FIG. 275 displays the alert module 27032. The process may begin with the alert module 27032 being, at step 27500, initiated by the base module 27024. The alert module 27032 may select, at step 27502, the first entry in the check bet database 27534. The first entry may refer to the earliest in time, the first location in memory, the highest priority entry, etc. The alert module 27032 may send, at step 27504, an alert to the wagering app 27010 on the mobile device 27008 associated with the user ID of the selected entry. The alert may be a notification of an uncommon bet, for example, a message that reads “Did you mean to bet [amount bet]?” or “This wager is uncommon for you. You may want to cancel the wager if there is an error”. The alert may contain elements that may require user interaction to finalize the wager, for example, a pop-up that reads “Are you sure you want to bet [amount bet]?” and two buttons that read “yes” and “no.” In which case the wager may be canceled if the user does not press the “yes” button within a time window. The alert module 27032 may determine, at step 27506, if there is another entry in the check bet database 27034. If there is another entry in the check bet database 27034, the alert module 27032 may select, at step 27508, the next entry and may return to step 27504. If there are no more entries in the check bet database, the alert module 27032 may end at step 27510. The alert module 27032 may delete all the entries in the check bet database or note which entries have caused an alert.

FIG. 276 displays the check bet database 27034. The check bet database 27034 may contain a user ID, such as JS1234, a timestamp, for example, 9:38 PM, and which module or modules flagged the user for uncommon betting behavior, for example, “single bet check module.”

It should be understood that the embodiments and examples discussed herein are merely exemplary and are non-limiting.

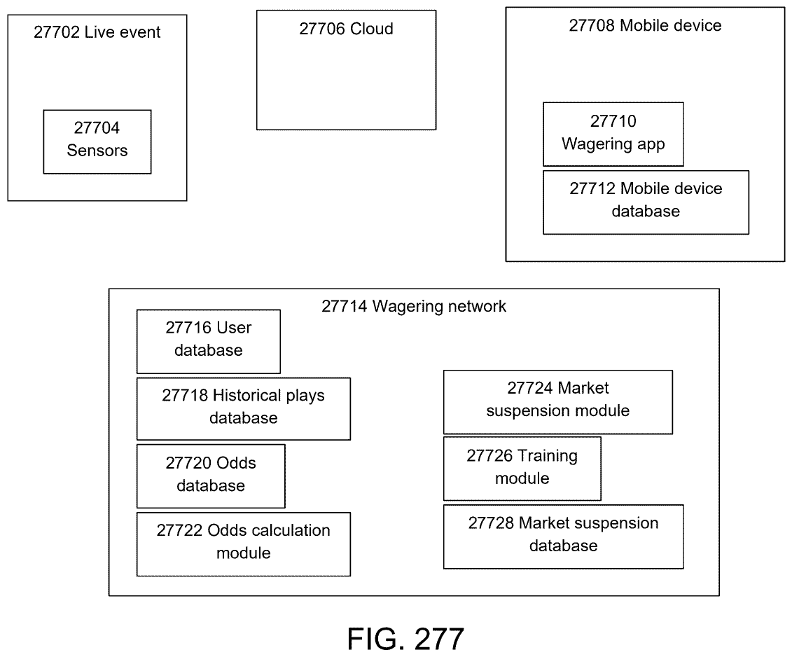

FIG. 277: illustrates a system for suspending a micro-market through a visual indicator, according to an embodiment.

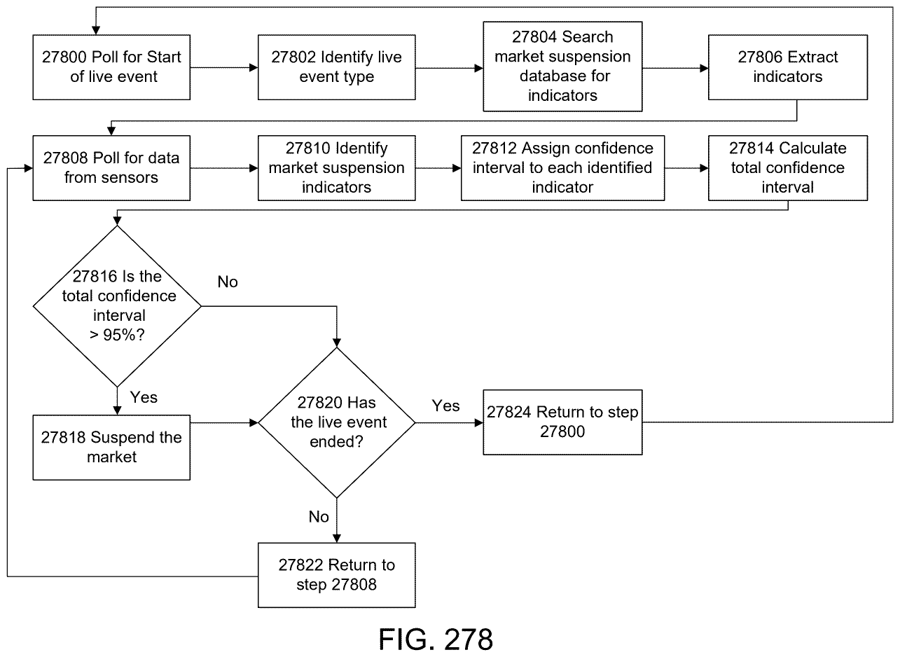

FIG. 278: illustrates a market suspension module, according to an embodiment.

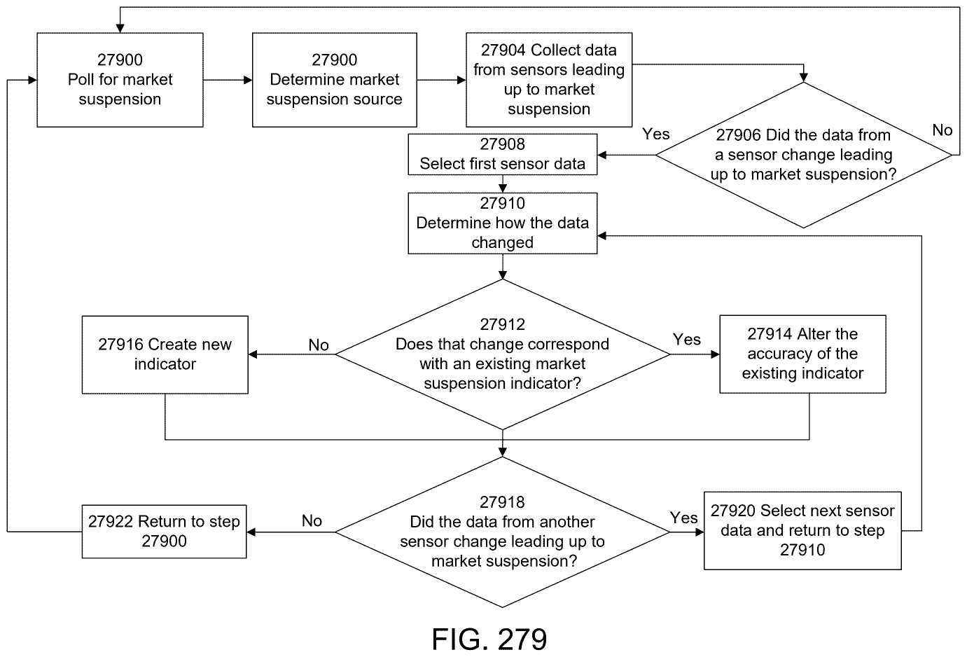

FIG. 279: illustrates a training module according to an embodiment.

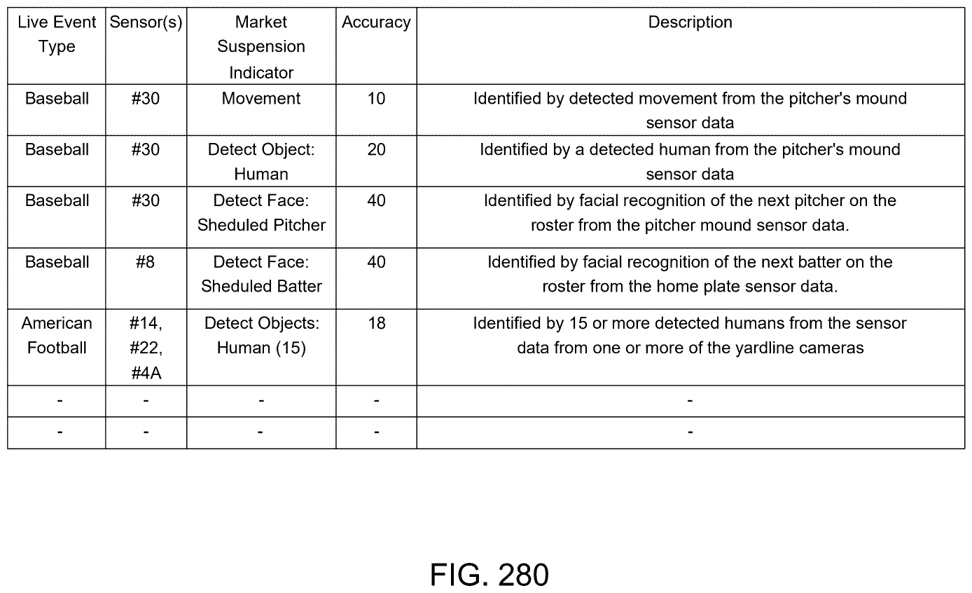

FIG. 280: illustrates a market suspension database, according to an embodiment.

FIG. 277 displays a system for suspending a micro-market through a visual indicator. This system may include a live event 27702, for example, a sporting event such as a football game, basketball game, baseball game, hockey game, tennis match, golf tournament, eSports or digital game, etc. The live event 27702 may include some number of actions or plays, upon with a user or bettor or customer can place a bet or wager, typically through an entity called a sportsbook. There are numerous types of wagers the bettor can make, including, but not limited to, a straight bet, a money line bet, a bet with a point spread or line that the bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk. This is typically applied to round-robin or other tournaments' styles. There are other types of wagers, including parlays, teasers, and prop bets, that are added games that often allow the user to customize their betting by changing the odds and payouts they receive on a wager. Certain sportsbooks will allow the bettor to buy points, to move the point spread off of the opening line. This will increase the price of the bet, sometimes by increasing the juice, vig, or hold that the sportsbook takes. Another type of wager the bettor can make is an over/under, in which the user bets over or under a total for the live event 27702, such as the score of American football or the run line in baseball, or a series of action in the live event 27702. Sportsbooks have several bets they can handle, a limit of wagers they can take on either side of a bet before they will move the line or odds off of the opening line. Additionally, there are circumstances, such as an injury to an important player such as a listed pitcher, in which a sportsbook, casino, or racino will take an available wager off the board. As the line moves, there becomes an opportunity for a bettor to bet on both sides at different point spreads to middle and win both bets. Sportsbooks will often offer bets on portions of games, such as first-half bets and half-time bets. Additionally, the sportsbook can offer futures bets on live events in the future. Sportsbooks need to offer payment processing services in order to cash out customers. This can be done at kiosks at the live event 27702 or at another location.

Further, embodiments may include a plurality of sensors 27704 that may be used such as motion sensors, temperature sensors, humidity sensors, optical sensors and cameras such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices, etc. Also, the plurality of sensors 27704 may include tracking devices, such as RFID tags, GPS chips, or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 27706 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, and other communication techniques that are known in the art. The communication network may allow ubiquitous access to shared pools of configurable system resources and higher-level services that can be rapidly provisioned with minimal management effort, often over the internet, and relies on sharing of resources to achieve coherence and economics of scale, like a public utility. In contrast, third-party clouds allow organizations to focus on their core businesses instead of expending resources on computer infrastructure and maintenance. The cloud 27706 may be communicatively coupled to a peer-to-peer wagering network 27714, which may perform real-time analysis on the type of play and the result of the play. The cloud 27706 may also be synchronized with game situational data, such as the time of the game, the score, location on the field, weather conditions, and the like, which may affect the choice of play utilized. For example, in some exemplary embodiments, the cloud 27706 may not receive data gathered from the sensors 27704 and may, instead, receive data from an alternative data feed, such as Sports Radar®. This data may be compiled substantially immediately following the completion of any play, and the data from this feed may be compared with a variety of team data and league data based on a variety of elements, including down, possession, score, time, team, and so forth, as described in various exemplary embodiments herein.

Further, embodiments may include a mobile device 27708 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs by combining some of the inputs and outputs. Some devices allow for facial recognition, which may be utilized as an input for different purposes, including authentication and other commands. Some devices provide for voice recognition and inputs, including, e.g., Microsoft KINECT, SIRI for iPhone by Apple, Google Now, or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality, including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control the I/O devices. The I/O controller may control one or more I/O devices, such as, e.g., a keyboard and a pointing device, e.g., a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., a USB bus, a SCSI bus, a FireWire bus, an Ethernet bus, a Gigabit Ethernet bus, a Fiber Channel bus, or a Thunderbolt bus. In other embodiments, the mobile device 27708 could be an optional component and would be utilized in a situation where a paired wearable device utilizes the mobile device 27708 as additional memory or computing power or connection to the internet.

Further, embodiments may include a wagering software application or a wagering app 27710, which is a program that enables the user to place bets on individual plays in the live event 27702 and display the audio and video from the live event 27702, along with the available wagers on the mobile device 27708. The wagering app 27710 allows the user to interact with the wagering network 27714 to place bets and provide payment/receive funds based on wager outcomes.

Further, embodiments may include a mobile device database 27712 that may store some or all of the user's data, the live event 27702, or the user's interaction with the wagering network 27814.

Further, embodiments may include the wagering network 27714, which may perform real-time analysis on the type of play and the result of a play or action. The wagering network 27714 (or the cloud 27706) may also be synchronized with game situational data, such as the time of the game, the score, location on the field, weather conditions, and the like, which may affect the choice of play utilized. For example, in other exemplary embodiments, the wagering network 27714 may not receive data gathered from the sensors 27704 and may, instead, receive data from an alternative data feed, such as SportsRadar®. This data may be provided substantially immediately following the completion of any play, and the data from this feed may be compared with a variety of team data and league data based on a variety of elements, including down, possession, score, time, team, and so forth, as described in various exemplary embodiments herein. The wagering network 27714 can offer several software as a service managed services such as user interface service, risk management service, compliance, pricing and trading service, IT support of the technology platform, business applications, game configuration, state-based integration, fantasy sports connection, integration to allow the joining of social media, as well as marketing support services that can deliver engaging promotions to the user.

Further, embodiments may include a user database 27716, which may contain data relevant to all users of the wagering network 27714, which may include a user ID, a device identifier, a paired device identifier, wagering history, and wallet information for the user. The user database 27716 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 27716 may contain betting lines and search queries. The user database 27716 may be searched based on a search criterion received from the user. Each betting line may include a plurality of betting attributes such as at least one of the live event 27702, a team, a player, an amount of wager, etc. The user database 27716 may include information related to all the users involved in the live event 27702. In an exemplary embodiment, the user database 27716 may include information for generating a user authenticity report and a wagering verification report. Further, the user database 27716 may be used to store user statistics like, but not limited to, the retention period for a particular user, frequency of wagers placed by a particular user, the average amount of wager placed by each user, etc.

Further, embodiments may include a historical plays database 27718 that may contain play data for the type of sport being played in the live event 27702. For example, in American Football, for optimal odds calculation, the historical play data should include metadata about the historical plays, such as time, location, weather, previous plays, opponent, physiological data, etc.

Further, embodiments may utilize an odds database 27720 that contains the odds calculated by an odds calculation module 27722 to display the odds on the user's mobile device 27808 and to take bets from the user through the mobile device wagering app 27710.

Further, embodiments may include the odds calculation module 27722, which utilizes historical play data to calculate odds for in-play wagers.

Further, embodiments may include a market suspension module 27724, which may examine the video of the live event 27702 to identify market suspension indicators. The market suspension module 27724 may suspend the market by preventing further wagers from being placed. The market suspension module 27724 may suspend the market after reaching a threshold confidence interval that the market should be suspended based on the identified market suspension indicators.

Further, embodiments may include a training module 27726, which may poll for when the market has been suspended and determine which sets of data coming from the sensors 27704 may be market suspension indicators.

Further, embodiments may include a market suspension database 27728, which may store all of the market suspension indicators used by the market suspension module 27724 to identify a market suspension condition in the live event 27702, such as the offense breaking the huddle in an NFL game, or the pitcher stepping on the rubber in an MLB game. The market suspension database 27728 may also contain an evaluation of the accuracy of each indicator from the training module 27726.

FIG. 278 displays the market suspension module 27724. The process may begin with the market suspension module 27724 polling, at step 27800, for the start of the live event 27702. The market suspension module 27724 may identify, at step 27802, the type of live event 27702. For example, an American football game, a baseball game, a horse race, etc. The market suspension module 27724 may search, at step 27804, the market suspension database 27728 for market suspension indicators that are relevant to the type of live event 27702. The market suspension module 27724 may extract, at step 27806, the market suspension indicators from the market suspension database 27728. The market suspension module 27724 may poll, at step 27808, for data from the sensors 27704 of the live event 27702. This may include video data and other types of data such as pressure sensor data. The market suspension module 27724 may identify, at step 27810, market suspension indicators in the data from the sensors 27704. Market indicators may be any data or change in data from the sensors 27704 that indicates that play of the live event 27702 is commencing. Therefore, the betting market needs to be suspended to ensure that wagers are not still accepted by the system for the outcome of a play that has already been decided. An example of a market suspension indicator may be movement detected at sensor #30, which is a camera pointed at the pitcher's mound of a baseball game. The market suspension module 27724 may use image recognition techniques to identify objects or persons relevant to the market suspension indicators. For example, one market suspension indicator may be that a human appears in sensor #30, which is a camera pointed at the pitcher's mound of a baseball game. The market suspension module 27724 may use facial recognition to identify players relevant to the market suspension indicators. For example, one market suspension indicator may be that one of the pitchers of the pitching team appears in sensor #30, which is a camera pointed at the pitcher's mound of a baseball game. The market suspension module 27724 may assign, at step 27812, a confidence interval to each identified market suspension indicator. The confidence interval may reflect the likelihood that the identification of the market suspension indicator is correct. For example, the market suspension indicator is that a human appears in sensor #30, which is a camera pointed at the pitcher's mound of a baseball game. The market suspension module 27724 identifies an object in sensor #30, but the object has only begun to enter the sensor's field of view. Based on the current amount of data available from the sensors 27704, the market suspension module 27724 determines a 25% chance this object is a human. Therefore, the confidence interval is 25%. The market suspension module 27724 may calculate, at step 27814, the total confidence interval for all identified market suspension indicators. The total confidence interval may combine the confidence interval from each identified market indicator and give greater weight to the market suspension indicators that more accurately predict the commencement of the next play. For example, one market suspension indicator may be that a human appears in sensor #30, which is a camera pointed at the pitcher's mound of a baseball game. A second market suspension indicator may be that one of the pitchers of the pitching team appears in sensor #30, which is a camera pointed at the pitcher's mound of a baseball game. The market suspension module 27724 assigns a confidence interval to these market suspension indicators of 95% and 80%, respectively. In other words, there is a 95% chance that a human appears in sensor #30, but only 80% that the human that appears is the pitcher for the pitching team. The accuracy of the market suspension indicators are 20 and 40, respectively; these accuracy values are stored in the market suspension database 27728 and are determined and adjusted by the training module 27726. The second market suspension indicator is assigned a higher accuracy because the pitcher appears near the pitcher's mound and is more likely to indicate the commencement of the next play than any human appearing near the pitcher's mound. The total confidence interval may then be calculated by a weighted average, resulting in a total confidence interval of 85%. Indicators that are not identified may be included as 0% confidence interval and reduce the total confidence interval if they are absent. Indicators may have a negative accuracy which may mean that they indicate that the play is not about to commence, for example, players moving off the field or non-players moving onto the field. The market suspension module 27724 may determine, at step 27816, if the total confidence interval is above 95%. The confidence interval threshold may be a value different than 95%. The confidence interval threshold may be set by an administrator of the system or another module and may be static or dynamic. If the total confidence interval is not above 95%, the market suspension module 27724 may skip to step 27820. If the total confidence interval is above 95%, the market suspension module 27724 may suspend, at step 27818, the wagering market. The market may be suspended until the end of the current play when the market for wagering on the next play opens. The market may be reopened for the current play if the confidence interval falls below a threshold value. The market suspension module 27724 may determine, at step 27820, if the live event 27702 has ended. If the live event 27702 has not ended, the market suspension module 27724 may return, at step 27822, to step 27808. If the live event 27702 has ended, the market suspension module 27724 may return, at step 27824, to step 27800.

FIG. 279 displays the training module 27726. The process may begin with the training module 27726 polling, at step 27900, for market suspension. The training module 27726 may determine, at step 27902, what caused the market to be suspended. For example, the market may be suspended by the market suspension module 27724, by a pre-set betting window, by another module, or manually by an administrator. The source of the market suspension may affect the accuracy of the market suspension indicators. For example, when the market is suspended manually by an administrator, the training module 27726 may assign a higher accuracy value to any concurrent indicators than it would if a pre-set betting window suspended the market. This is because the administrator may be a more trustworthy authority than a pre-set betting window. The training module 27726 may collect, at step 27904, data from the sensors 27704 leading up to the market suspension. Leading up may mean an amount of time before the suspension of the market, for example, thirty seconds. This leading-up time may be set by an administrator or another module and may be static or dynamic. The leading-up time may be different for each of the sensors 27704. The training module 27726 may determine, at step 27906, if the data from at least one of the sensors 27704 changed in the time leading up to the market suspension. For example, the data from a sensor may have changed from relatively static to dynamic, indicating movement. The training module 27726 may use object detection software to determine if the change in data is indicative of the presence or absence of objects such as a baseball, a person, a flag, a foot or shoe, etc. For example, leading up to market suspension sensor may change from detecting no objects to detecting a person. This person may be a pitcher approaching the pitcher's mound. Small changes in data, such as a few pixels difference from frame to frame, may be ignored. If no data from any of the sensors 27704 changed, the training module 27726 may return to step 27900. If the data from at least one of the sensors 27704 changed when leading up to the market suspension, the training module 27726 may select, at step 27908, data from the first of the sensors 27704 that changed leading up to the market suspension. First may mean the first sensor that changed based on time, the first sensor based on how sensors 27704 are identified, a sensor selected randomly, etc. The training module 27726 may determine, at step 27910, how the data from the selected sensor changed leading up to the market suspension. For example, sensor #30 is a camera pointed a the pitcher's mound in a baseball game. Leading up to the market suspension, the pitcher walked to the pitcher's mound and into view of sensor #30. At the beginning of the time leading up to the market suspension, data from camera #30 was mostly static. Ten seconds before the market suspension, the movement was detected in the data from sensor #30. At eight seconds before the market suspension, a person was detected by image recognition software in the data from sensor #30. At seven seconds before the market suspension, the pitcher was identified by facial recognition software in the data from sensor #30. Each of these events, movement detected, person detected, or identified, may be determined to be changes leading up to the market suspension. The training module 27726 may search, at step 27912, the market suspension database 27728 for market suspension indicators that correspond with the changes detected. For example, if the movement was detected in sensor #30 leading up to market suspension in a baseball game, the training module 27726 will search the suspension database for an entry that includes sensor #30, a change from no movement to movement, and baseball as the live event 27702. If there is already an existing market suspension indicator that corresponds to the change in data from the selected sensor, the training module 27726 may alter, at step 27914, the accuracy of the existing indicator in the market suspension database 27728. For example, a movement was detected in sensor #30, leading to a market suspension in a baseball game. The accuracy of the existing entry for movement on sensor #30 in a baseball game may be increased. Therefore, changes in data that often happen before market suspension may increase accuracy faster than changes that happen less often. The training module 27726 may decrease accuracy each time an indicator is not identified before a market suspension. The training module 27726 may decrease accuracy when each time the opposite change occurs before a market suspension. For example, a movement was detected in sensor #30 at the beginning of the lead-up time to market suspension, and during that time, the movement stopped. The training module 27726 may then decrease the accuracy for the existing entry of movement on sensor #30 in a baseball game. If there is no existing market suspension indicator that corresponds to the change in data from the selected sensor, the training module 27726 may, at step 27916, create an entry in the market suspension database 27728 that corresponds to the detected change. For example, a movement was detected in sensor #30, leading to a market suspension in a baseball game. The training module 27726 will create an entry that includes sensor #30, a change from no movement to movement, and baseball as the live event 27702. The training module 27726 may determine, at step 27918, if the data from another sensor also changed leading up to the market suspension. If the data from another sensor also changed leading up to the market suspension, the training module 27726 may select, at step 27920, the next sensor and return to step 27910. If no data from any other sensor changed leading up to the market suspension, the training module 27726 may return, at step 27922, to step 27900.

FIG. 280 displays the market suspension database 27728. The market suspension database 27728 may contain a live event 27702 type, for example, baseball. The market suspension database 27728 may contain one or more of the sensors 27704 relevant to identifying a market suspension indicator, for example, sensor #30. The market suspension database 27728 may contain a market suspension indicator that indicates the circumstances that influence market suspension, for example, detected movement. The market suspension database 27728 may contain an accuracy rating, for example, 10, which is used by the market suspension module 27724 to determine which market suspension indicators are more important to the final determination of whether to suspend the wagering market. This accuracy rating is generated and adjusted over time by the training module 27726. Market suspension indicators that always or often coincide with the suspension of the market have their accuracy increased over time to high accuracy. Indicators with high accuracy may be able to cause the suspension of the market without other indicators if the indicator has a high enough confidence interval. Market suspension indicators which only sometimes coincide with the suspension of the market, may have low accuracy. Indicators with a low accuracy may be able to cause the suspension of the market if they occur simultaneously with other low accuracy indicators. Accuracy may be used by the market suspension module 27724 to take a weighted average of the confidence interval of each market suspension indicator. This total confidence interval may then be used to determine if the market should be suspended. The market suspension database 27728 may contain a plain text description of the market suspension indicator, for example, “identified by detected movement from the pitcher's mound sensor data.”

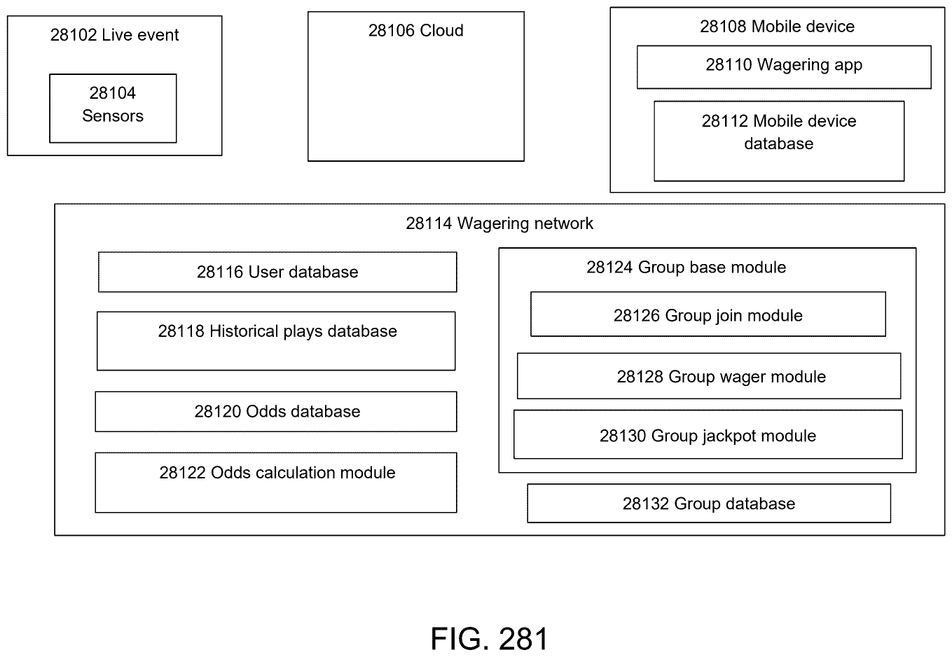

FIG. 281 illustrates a system for group wagering with a progressive jackpot, according to an embodiment.

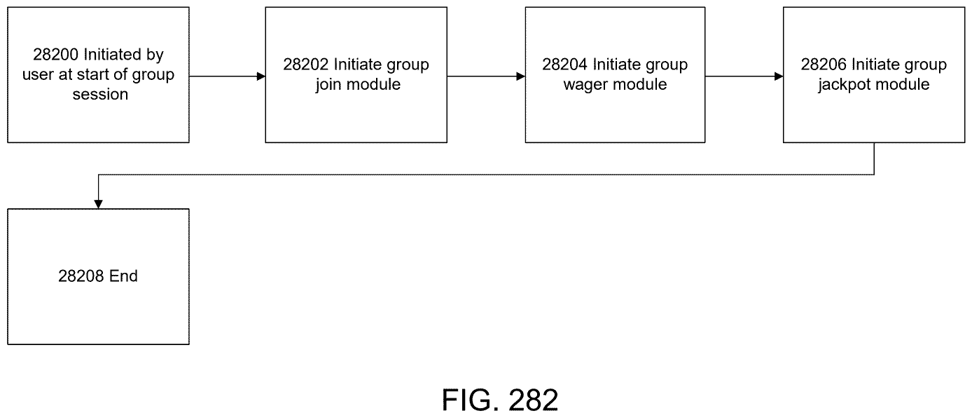

FIG. 282 illustrates a group base module, according to an embodiment.

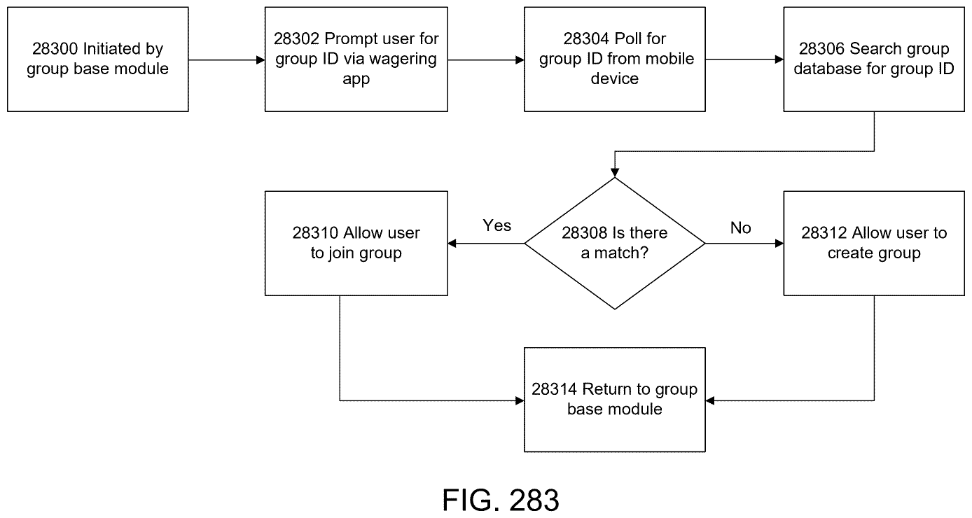

FIG. 283 illustrates a group join module, according to an embodiment.

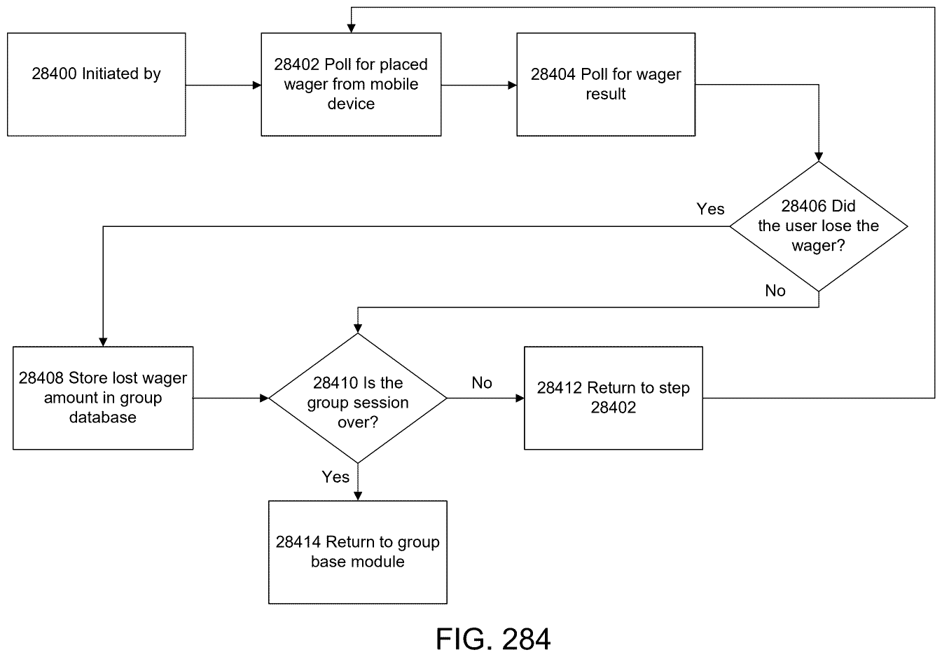

FIG. 284 illustrates a group wager module, according to an embodiment.

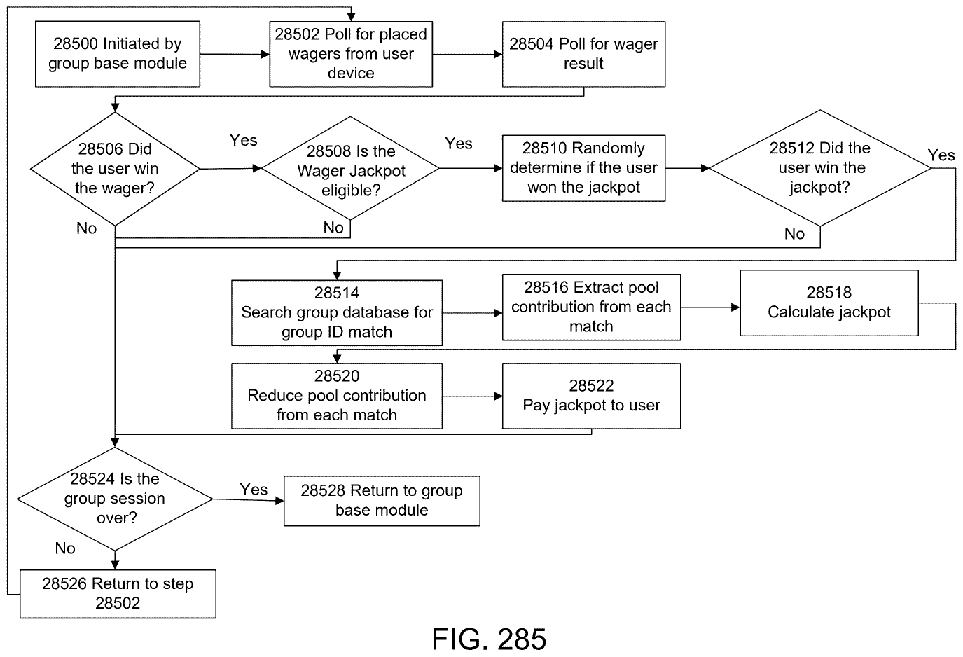

FIG. 285 illustrates a group jackpot module, according to an embodiment.

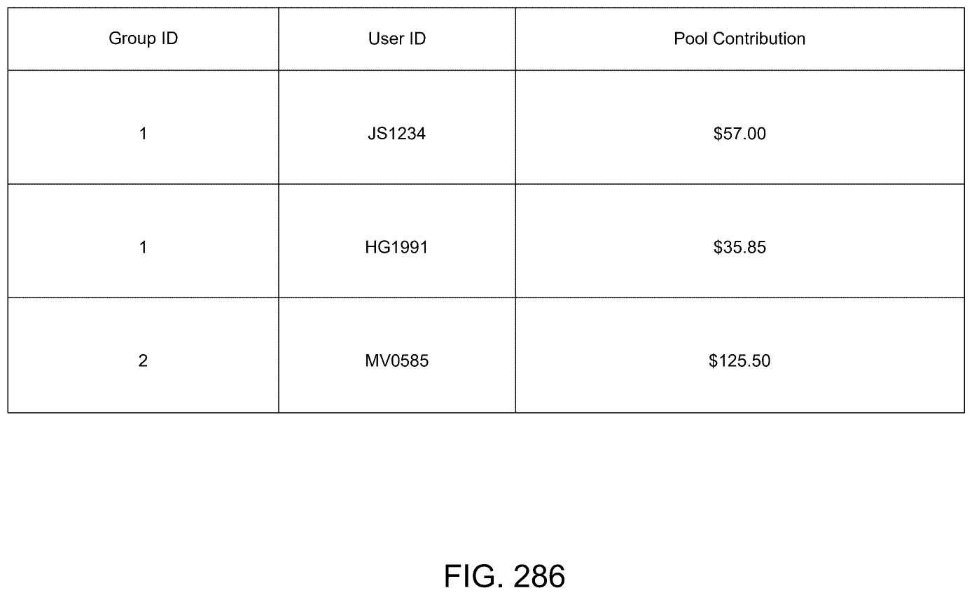

FIG. 286 illustrates a group database, according to an embodiment.

FIG. 281 displays a system for group wagering with a progressive jackpot. This system may include a live event 28102, for example, a sporting event such as a football, basketball, baseball, or hockey game, tennis match, golf tournament, eSports, or digital game, etc. The live event 28102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 28102, such as the score of an American football game or the run line in a baseball game, or a series of actions in the live event 28102. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live event 28102 in the future. Sportsbooks need to offer payment processing services to cash out customers which can be done at kiosks at the live event 28102 or at another location.

Further, embodiments may include a plurality of sensors 28104 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 28104 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 28106 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 28106 may be communicatively coupled to a peer-to-peer wagering network 28114, which may perform real-time analysis on the type of play and the result of the play. The cloud 28106 may also be synchronized with game situational data such as the time of the game, the score, location on the field, weather conditions, and the like, which may affect the choice of play utilized. For example, in an exemplary embodiment, the cloud 28106 may not receive data gathered from the sensors 28104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 28108 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 28108 could be an optional component and would be utilized in a situation where a paired wearable device employs the mobile device 28108 for additional memory or computing power or connection to the internet.

Further, embodiments may include a wagering software application or a wagering app 28110, which is a program that enables the user to place bets on individual plays in the live event 28102, streams audio and video from the live event 28102, and features the available wagers from the live event 28102 on the mobile device 28108. The wagering app 28110 allows the user to interact with the wagering network 28114 to place bets and provide payment/receive funds based on wager outcomes.

Further, embodiments may include a mobile device database 28112 that may store some or all the user's data, the live event 28102, or the user's interaction with the wagering network 28114.

Further, embodiments may include the wagering network 28114, which may perform real-time analysis on the type of play and the result of a play or action. The wagering network 28114 (or the cloud 28106) may also be synchronized with game situational data, such as the time of the game, the score, location on the field, weather conditions, and the like, which may affect the choice of play utilized. For example, in an exemplary embodiment, the wagering network 28114 may not receive data gathered from the sensors 28104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 28114 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 28116, which may contain data relevant to all users of the wagering network 28214 and may include, but is not limited to, a user ID, a device identifier, a paired device identifier, wagering history, or wallet information for the user. The user database 28116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 28116 may contain betting lines and search queries. The user database 28116 may be searched based on a search criterion received from the user. Each betting line may include but is not limited to, a plurality of betting attributes such as at least one of the following: the live event 28102, a team, a player, an amount of wager, etc. The user database 28116 may include, but is not limited to, information related to all the users involved in the live event 28102. In one exemplary embodiment, the user database 28116 may include information for generating a user authenticity report and a wagering verification report. Further, the user database 28116 may be used to store user statistics like, but not limited to, the retention period for a particular user, frequency of wagers placed by a particular user, the average amount of wager placed by each user, etc.

Further, embodiments may include a historical plays database 28118 that may contain play data for the type of sport being played in the live event 28102. For example, in American Football, for optimal odds calculation, the historical play data may include metadata about the historical plays, such as time, location, weather, previous plays, opponent, physiological data, etc.

Further, embodiments may utilize an odds database 28120—that contains the odds calculated by an odds calculation module 28122—to display the odds on the user's mobile device 28108 and take bets from the user through the mobile device wagering app 28110.

Further, embodiments may include the odds calculation module 28122, which may utilize historical play data to calculate odds for in-play wagers.

Further, embodiments may include a group base module 28124, which may initiate a group join module 28126, a group wager module 28128, and a group jackpot module 28130.

Further, embodiments may include the group join module 28126, which may allow a user to join or create a group.

Further, embodiments may include the group wager module 28128, which may poll for wagers lost by a group member. Then, some or all of the amount of money or points the group member lost may be added to a group jackpot.

Further, embodiments may include the group jackpot module 28130, which may poll for wagers won by a group member. If the wager meets certain criteria, the group member who placed the wager may be eligible for the group jackpot. The group jackpot may be awarded randomly to any group member that won an eligible wager.

Further, embodiments may include a group database 28132, which may store information on which users are members of which groups and the current jackpot for that group.

FIG. 282 displays the group base module 28124. The process may begin with the group base module 28124 being initiated, at step 28200, by a user at the start of a group session. The group base module 28124 may be initiated via the wagering app 28110 on the mobile device 28108 of the user. The group base module 28124 may initiate, at step 28202, the group join module 28126. The group join module 28126 may allow a user to join or create a group. The group base module 28124 may initiate, at step 28204, the group wager module 28128. The group wager module 28128 may poll for wagers that a member of a group lost. Then, some or all of the amount of money or points the group member lost may be added to a group jackpot. The group base module 28124 may initiate, at step 28206, the group jackpot module 28130. The group jackpot module 28130 may poll for wagers that a member of the group wins. If the wager meets certain criteria, the group member who placed the wager may be eligible for the group jackpot. The group jackpot may be awarded randomly to any group member that won an eligible wager. The group base module 28124 may end at step 28208.

FIG. 283 displays the group join module 28126. The process may begin with the group join module 28126 being initiated, at step 28300, by the group base module 28124. The group join module 28126 may prompt the user, at step 28302, for a group ID via the wagering app 28110. The user may refer to the user that initiated the group base module 28124. The group join module 28126 may poll, at step 28304, for a group ID from the mobile device 28108. If the user has received an invite to a group, the group ID may be sent automatically. Users may create their own group ID such as “Bob's group” or hit a create group button to randomly generate a group ID. The group join module 28126 may search, at step 28306, the group database 28132 for a group ID that matches the group ID received from the mobile device 28108. The group join module 28126 may determine, at step 28308, if there is a match in the group database 28132. The match may not need to be an exact match. For example, the user may have a typo in the group ID and may be prompted to correct the error. If there is a match in the group database 28132, the group join module 28126 may allow the user, at step 28310, to join the matching group. The user ID of the user and the group ID may be associated and stored in the group database 28132. The group join module 28126 may require the user to enter a password to join. If there is no match in the group database 28132, the group join module 28126 may allow the user, at step 28312, to create a new group. The user ID of the user and the group ID may be associated and stored in the group database 28132. The user may be able to adjust settings for the group and may receive special permissions as the group's creator. The group join module 28126 may return, at step 28314, to the group base module 28124.

FIG. 284 displays the group wager module 28128. The process may begin with the group wager module 28128 being initiated, at step 28400, by the group base module 28124. The group wager module 28128 may poll, at step 28402, for placed wagers from the mobile device 28108. The group wager module 28128 may alternatively poll for new wagers in the user database 28116 that the user placed. The group wager module 28128 may poll, at step 28404, for the result of the placed wager. The group wager module 28218 may determine, at step 28406, if the user lost the wager. If the user won the wager, the group wager module 28128 may skip to step 28410. If the user lost the wager, the group wager module 28128 may store, at step 28408, the amount lost, or a portion of the amount lost, in the group database 28132. The amount may be associated with the user ID and the group ID of the current group session. If the user participates in multiple group sessions simultaneously, the amount may be split between multiple groups. The amount may be added to the amount the user has previously lost. The group wager module 28128 may determine, at step 28410, if the group session has ended. The group session may end for the individual user without ending for every member of the group. The user may leave the group session at will or may be removed from the group. If the group session is not over, the group wager module 28128 may return, at step 28412, to step 28402. If the group session is over, the group wager module 28128 may return, at step 28414, to the group base module 28124.

FIG. 285 displays the group jackpot module 28130. The process may begin with the group jackpot module 28130 being initiated, at step 28500, by the group base module 28124. The group jackpot module 28130 may poll, at step 28502, for placed wagers from the mobile device 28108. The group jackpot module 28130 may alternatively poll for new wagers in the user database 28116 that the user placed. The group jackpot module 28130 may poll, at step 28504, for the result of the placed wager. The group jackpot module 28130 may determine, at step 28506, if the user won the wager. If the user lost the wager, the group jackpot module 28130 may skip to step 28524. If the user won the wager, the group jackpot module 28130 may determine, at step 28508, if the wager is jackpot eligible. The wager may be jackpot eligible if only one user in a group won the wager. Jackpot eligibility may be based on several criteria such as, the number of group members who placed the wager, the odds of the wager, the significance of the event wagered on, the number of members who won the wager, the duration of the group session, etc. Jackpot eligibility criteria may be set by an administrator, a user, or another module. If the wager is not jackpot eligible the group jackpot module 28130 may skip to step 28524. If the wager is jackpot eligible, the group jackpot module 28130 may randomly determine, at step 28510, if the user won the jackpot. Jackpot eligibility may be determined by random number generation. For example, when an eligible wager is won, the group jackpot module 28130 may generate a random number between 1 and 100. If the number is 100, the user wins the jackpot. The probability of the user winning the jackpot may be set by an administrator of the system, a user, or another module. The group jackpot module 28130 may determine, at step 28512, if the user won the jackpot. If the user lost the jackpot, the group jackpot module 28130 may skip to step 28524. If the user won the jackpot, the group jackpot module 28130 may search, at step 28514, the group database 28132 for the user's associated group ID. If a user is in multiple groups, then each jackpot may be determined separately. The group jackpot module 28130 may extract, at step 28516, the pool contribution from each match or the pool contribution from each group member. The group jackpot module 28130 may calculate, at step 28518, the jackpot. The jackpot may be calculated by totaling up all the extracted pool contributions. The jackpot may be only a portion of the total, such as 70% or 50%. The group jackpot module 28130 may reduce, at step 28520, the pool contribution stored in the group database 28132 for each match. The amount of the reduction may be based on the calculated jackpot. For example, if the calculated jackpot is 50% of the total pool contributions, each pool contribution may only be reduced by 50%. In one embodiment the jackpot may have a limit, above which any losses are no longer contributing to the jackpot total. The jackpot limit may be defined by an administrator or may be dynamically determined by an algorithm. The limit may vary based on the risk to the wagering network 28112, the number of active participants, type of live event 28102, etc. In one embodiment, the jackpot portion of the total losses that are pool contributions to the jackpot may vary dynamically. For example, the pool contribution percentage may be larger as the number of participants increases. The percentage of lost wagers that are pool contributions to the jackpot may vary based on characteristics of an individual user, or the characteristics of a plurality of users in the group. For example, the average wager size of a user may impact the percentage of lost wagers contributed to the jackpot, with whales contributing a greater percentage of their lost wagers, thereby increasing the progressive jackpot faster and making it more attractive.

The group jackpot module 28130 may pay, at step 28522, the jackpot to the user or users who won the wager. Payment may occur directly to the mobile device 28108 or wagering app 28110. Payment may be stored in a database for later distribution. The group jackpot module 28130 may determine, at step 28524, if the group session has ended. The group session may end for the individual user without ending for every member of the group. The user may leave the group session at will or may be removed from the group. If the group session is not over, the group jackpot module 28130 may return, at step 28526, to step 28502. If the group session is over, the group jackpot module 28130 may return, at step 28528, to the group base module 28124.

FIG. 286 displays the group database 28132. The group database 28132 may contain the group IDs, user IDs of the group members, and an amount that member has contributed to the current pool. Pool contributions may be reset when a group member hits the jackpot. If users are allowed to be in multiple groups, their user ID may be associated with multiple group IDs, and the contribution amount in a given group may be specific to each group.

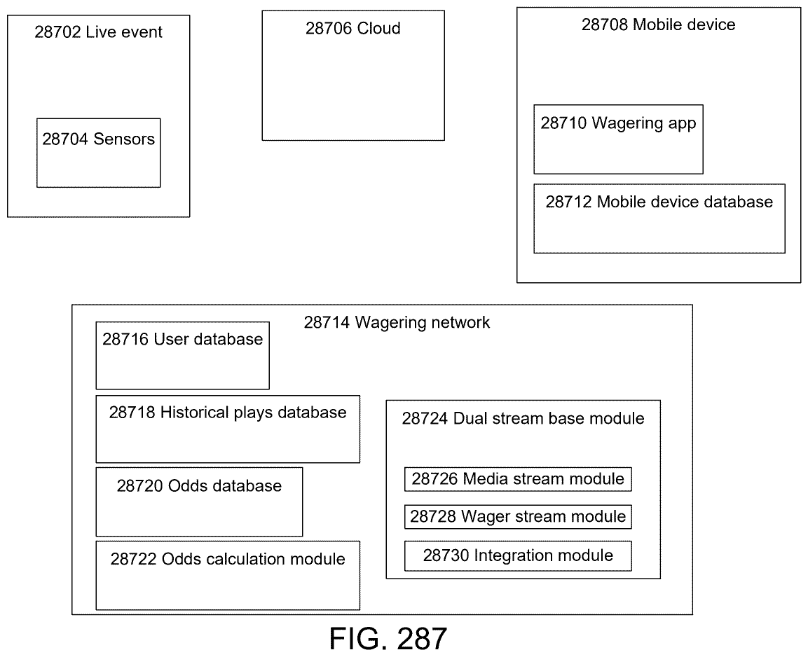

FIG. 287 illustrates a system for dual-stream video and wager data, according to an embodiment.

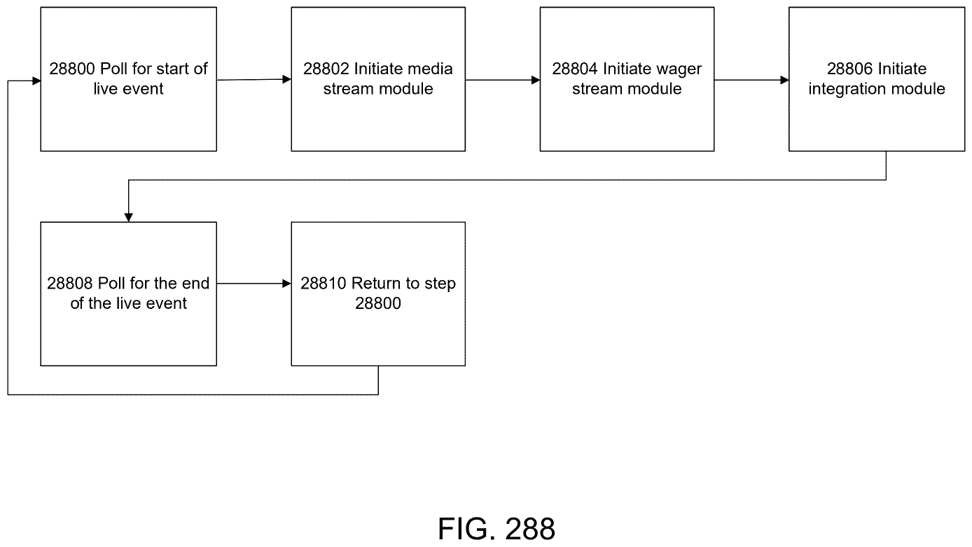

FIG. 288 illustrates a dual-stream base module, according to an embodiment.

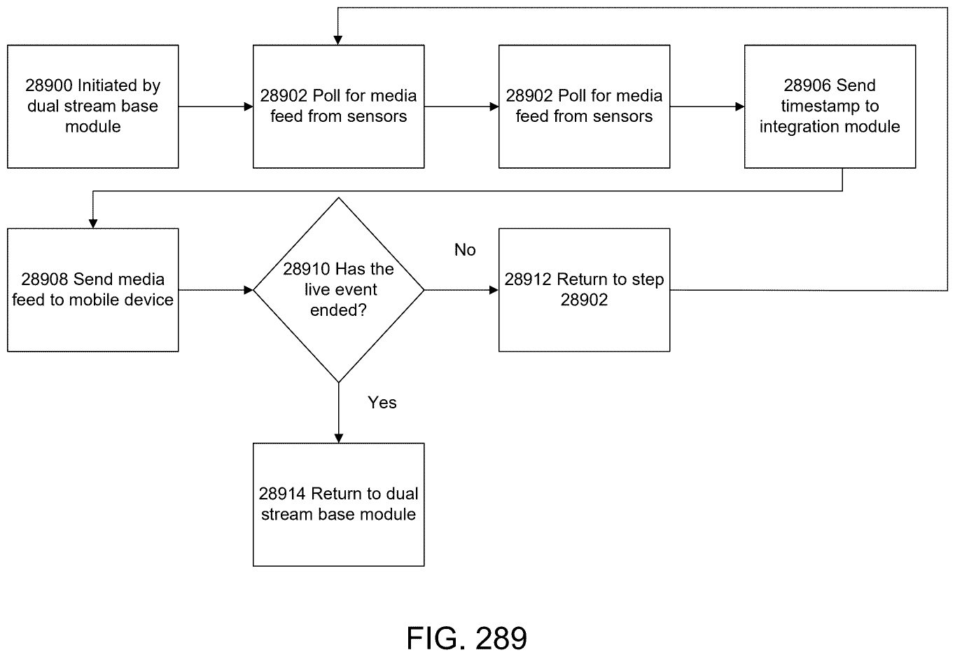

FIG. 289 illustrates a media stream module, according to an embodiment.

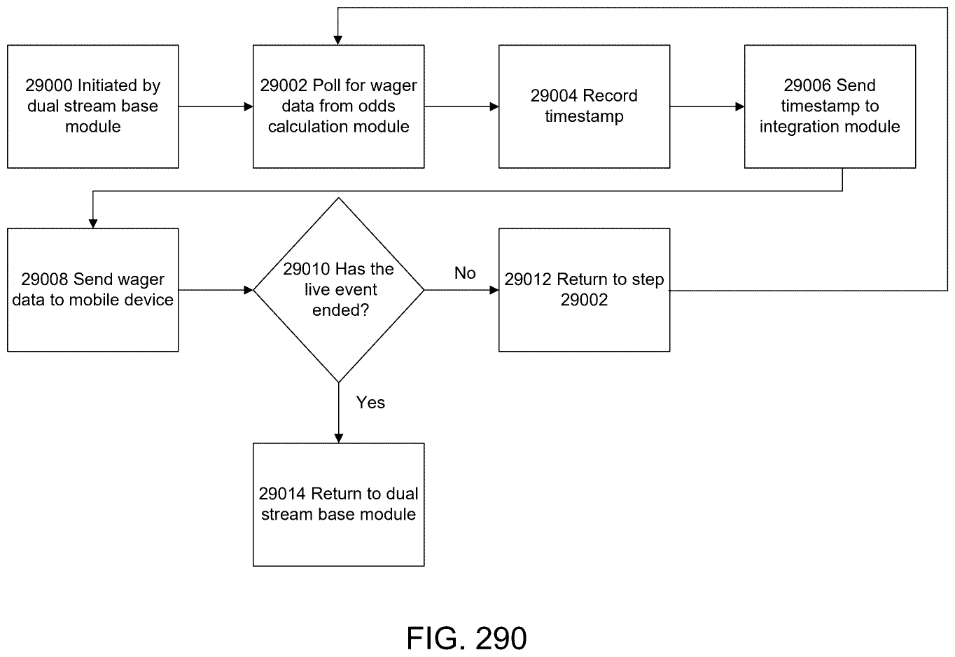

FIG. 290 illustrates a wager stream module, according to an embodiment.

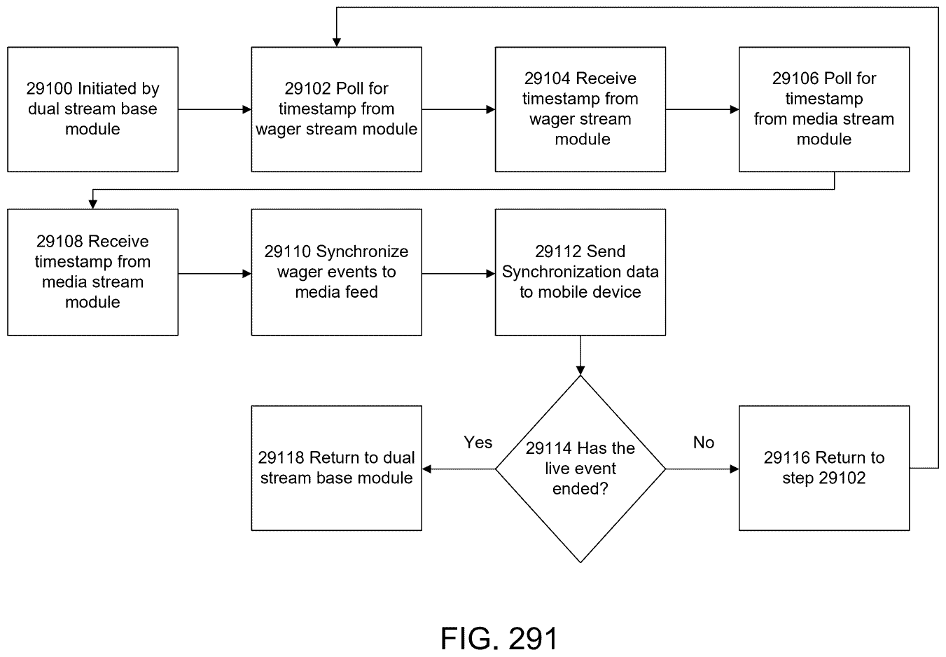

FIG. 291 illustrates an integration module, according to an embodiment.

FIG. 287 is a system for dual-stream video and wager data. This system may include a live event 28702, for example, a sporting event such as a football, basketball, baseball, or hockey game, tennis match, golf tournament, eSports or digital game, etc. The live event 28702 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 28702, such as the score of an American football game or the run line in a baseball game, or a series of actions in the live event 28702. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 28702 or at another location.

Further, embodiments may include a plurality of sensors 28704 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 28704 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 28706 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 28706 may be communicatively coupled to a peer-to-peer wagering network 28714, which may perform real-time analysis on the type of play and the result of the play. The cloud 28706 may also be synchronized with game situational data such as the time of the game, the score, location on the field, weather conditions, and the like, which may affect the choice of play utilized. For example, in an exemplary embodiment, the cloud 28706 may not receive data gathered from the sensors 28704 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 28708 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 28708 could be an optional component and would be utilized in a situation where a paired wearable device employs the mobile device 28708 for additional memory or computing power or connection to the internet.

Further, embodiments may include a wagering software application or a wagering app 28710, which is a program that enables the user to place bets on individual plays in the live event 28702, streams audio and video from the live event 28702, and features the available wagers from the live event 28702 on the mobile device 28708. The wagering app 28710 allows the user to interact with the wagering network 28714 to place bets and provide payment/receive funds based on wager outcomes.

Further, embodiments may include a mobile device database 28712 that may store some or all the user's data, the live event 28702, or the user's interaction with the wagering network 28714.

Further, embodiments may include the wagering network 28714, which may perform real-time analysis on the type of play and the result of a play or action. The wagering network 28714 (or the cloud 28706) may also be synchronized with game situational data, such as the time of the game, the score, location on the field, weather conditions, and the like, which may affect the choice of play utilized. For example, in an exemplary embodiment, the wagering network 28714 may not receive data gathered from the sensors 28704 and may, instead, receive data from an alternative data feed, such as SportsRadar®. This data may be provided substantially immediately following the completion of any play, and may be compared with a variety of team data and league data based on a variety of elements, including the current down, possession, score, time, team, and so forth, as described in various exemplary embodiments herein. The wagering network 28714 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 28716, which may contain data relevant to all users of the wagering network 28714 and may include, but is not limited to, a user ID, a device identifier, a paired device identifier, wagering history, or wallet information for the user. The user database 28716 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 28716 may contain betting lines and search queries. The user database 28716 may be searched based on a search criterion received from the user. Each betting line may include, but is not limited to, a plurality of betting attributes such as at least one of the live event 28702, a team, a player, an amount of wager, etc. The user database 28716 may include, but is not limited to, information related to all the users involved in the live event 28702. In one exemplary embodiment, the user database 28716 may include information for generating a user authenticity report and a wagering verification report. Further, the user database 28716 may be used to store user statistics like, but not limited to, the retention period for a particular user, frequency of wagers placed by a particular user, the average amount of wager placed by each user, etc.

Further, embodiments may include a historical plays database 28718 that may contain play data for the type of sport being played in the live event 28702. For example, in American Football, for optimal odds calculation, the historical play data may include metadata about the historical plays, such as time, location, weather, previous plays, opponent, physiological data, etc.

Further, embodiments may utilize an odds database 28720—that contains the odds calculated by an odds calculation module 28722—to display the odds on the user's mobile device 28708 and take bets from the user through the mobile device wagering app 28710.

Further, embodiments may include the odds calculation module 28722, which utilizes historical play data to calculate odds for in-play wagers.

Further, embodiments may include a dual-stream base module 28724, which may initiate a media stream module 28726 to collect media data from the sensors 28704 and send that data to the mobile device 28708. The dual-stream base module 28724 may initiate a wager stream module 28728 to collect wager data from the odds calculation module 28722 and send it to the mobile device 28708. The dual-stream base module 28724 may initiate an integration module 28730 to synchronize the wagering feed with the media feed from the live event 28702.

Further, embodiments may include the media stream module 28726, which may supply audio/video of the live event 28702 to the wagering app 28710. This module may also supply the timestamps of the media stream of the live event 28702 related to the audio/video and wagering data. It should be noted the timestamps are of the live event 28702, but the timestamps at the game players mobile device 28708 may be different due to latency; that is, gameplay may occur at 9:15 pm at the live event 28702, but the Media Stream data may reach the mobile device 28708 fifty milliseconds (high latency) later.

Further, embodiments may include the wager stream module 28728, which may supply wagering data to the wagering app 28710. Normally, this data is less likely to have latency because of the small amount of real-time data. This module will also supply its time stamps of wagering events such as the opening and closing of a betting window. It may be noted the timestamps are relative to the live event 28702, but the time stamps at the mobile device 28708 may be different due to latency; that is, gameplay may occur at 9:15 pm at the live event 28702, but the wager stream data may reach the mobile device 28708 ten milliseconds (low latency) later. Regardless of when the betting market appears to close on the wagering app 28710, wagers may not be accepted from the wagering app 28710 after the close of the betting market.

Further, embodiments may include the integration module 28730, which may provide the mobile device 28708 the information required to integrate the media stream and the wager stream. The module may send timestamps from both the wager and video data from the live event 28702. Using these timestamps, the wagering app 28710 can adjust the time of the two streams to be synchronized. This synchronization may cause the betting market to appear open longer than it is. A user may customize how this synchronization may occur, for example, the opening of the betting market is synchronized with the video stream, but the closing of the betting market is not.

FIG. 288 illustrates the dual-stream base module 28724. The process may begin with the dual-stream base module 28724 polling, at step 28800, for the start of the live event 28702. The dual-stream base module 28724 may initiate, at step 28802, the media stream module 28726 to collect media data from the sensors 28704 and send that data to the mobile device 28708. The dual-stream base module 28724 may initiate, at step 28804, the wager stream module 28728 to collect wager data from the odds calculation module 28722 and send it to the mobile device 28708. The dual-stream base module 28724 may initiate, at step 28806, the media stream module 28730 to synchronize the wagering feed with the media feed from the live event 28702. The dual-stream base module 28724 may poll, at step 28808, for the end of the live event 28702. The dual-stream base module 28724 may poll for each initiated module to return to the dual-stream base module 28724. The dual-stream base module 28724 may return, at step 28810, to step 28800. The dual-stream base module 28724 may instead end at this step and be re-initiated manually or by another module.

FIG. 289 illustrates the media stream module 28726. The process may begin with the media stream module 28726 being initiated, at step 28900, by the dual-stream base module 28724. The media stream module 28726 may poll, at step 28902, for a feed of media data from the sensors 28704. This feed of data may be received continuously. The media stream module 28726 may record, at step 28904, a timestamp when a discrete set of data is received from the sensors 28704. For example, if the media data is video data, the media stream module may record a timestamp for each video frame. The media stream module 28726 may send, at step 28906, the timestamp to the integration module 28730. The media stream module 28726 may send, at step 28908, the media feed to the mobile device 28708. The media stream module 28726 may determine, at step 28910, if the live event 28702 has ended. If the live event 28702 has not ended, the media stream module 28726 may return, at step 28912, to step 28902. If the live event 28702 has ended, the media stream module 28726 may return, at step 28914, to the dual-stream base module 28724.

FIG. 290 illustrates the wager stream module 28728. The process may begin with the wager stream module 28728 being initiated, at step 29000, by the dual-stream base module 28724. The wager stream module 28728 may poll, at step 29002, for wager data from the odds calculation module 28722. This data may be received when a wager is first offered at the opening of the betting market, when the betting market closes, or if the wagering options or odds change while the betting market is open. The wager stream module 28728 may record, at step 29004, a timestamp when data is received from the odds calculation module 28722. For example, when the betting market for a play of the live event 28702 has opened. The wager stream module 28728 may send, at step 29006, the timestamp to the integration module 28730. The wager stream module 28728 may send, at step 29008, the wager data to the mobile device 28708. The wager stream module 28728 may determine, at step 29010, if the live event 28702 has ended. If the live event 28702 has not ended, the wager stream module 28728 may return, at step 29012, to step 29002. If the live event 28702 has ended, the wager stream module 28728 may return, at step 29014, to the dual-stream base module 28724.

FIG. 291 illustrates the integration module 28730. The process may begin with the integration module 28730 being initiated, at step 29100, by the dual-stream base module 28724. The integration module 28730 may poll, at step 29102, for a timestamp from the wager stream module 28728. The integration module 28730 may receive, at step 29104, a timestamp from the wager stream module 28728. The integration module 28730 may poll, at step 29106, for a timestamp from the media stream module 28726. This step may occur concurrently to step 29102, or the integration module 28730 may not poll for a timestamp from the media steam module 28726 until a timestamp is received from the wager stream module 28728. The integration module 28730 may receive, at step 29108, a timestamp from the media stream module 28726. The integration module 28730 may synchronize, at step 29110, the wager events to the media feed. For example, the wagering market for a play opens at 9:15:00 PM. The video recording of the live event 28702 began at 9:00:00 PM. The corresponding timestamp in the media feed, assuming 60 frames per second, occurs at the 54,000th frame of the video recording of the live event 28702. Then, the market opening would be synchronized to frame 54,000 (frame 1 of minute 15) of the media feed. The frame rate for the video of the live event 28702 may be different than 60 frames per second. Each frame of the video stream may be embedded in the stream metadata such that the current frame of the video stream may be identified by the mobile device 28708. The integration module 28730 may send, at step 29112, the synchronization data to the mobile device 28708. This data may be used to synchronize the wager stream with the media stream on the wagering app 28710. For example, the wagering market for a play opens at 9:15:00 PM. The opening of the market is synchronized to frame 54,000 of the media feed. The mobile device 108 receives data that the wagering market is open at 9:15:01 PM. The mobile device 28708 receives synchronization data at 9:15:02 PM. The mobile device 108 receives frame 54,000 of the media feed at 9:15:09 PM. The wagering app 28710 may delay displaying that the wagering market has opened until frame 54,000 is received by the mobile device 28708. Therefore, the user may see that the wagering market is open at 9:15:09 PM. This delayed display may be an option selected by the user on the wagering app 28710. The integration module 28730 may determine, at step 29114, if the live event 28702 has ended. If the live event 28702 has not ended, the integration module 28730 may return, at step 29116, to step 29102. If the live event 28702 has ended, the integration module 28730 may return, at step 29118, to the dual-stream base module 28724.

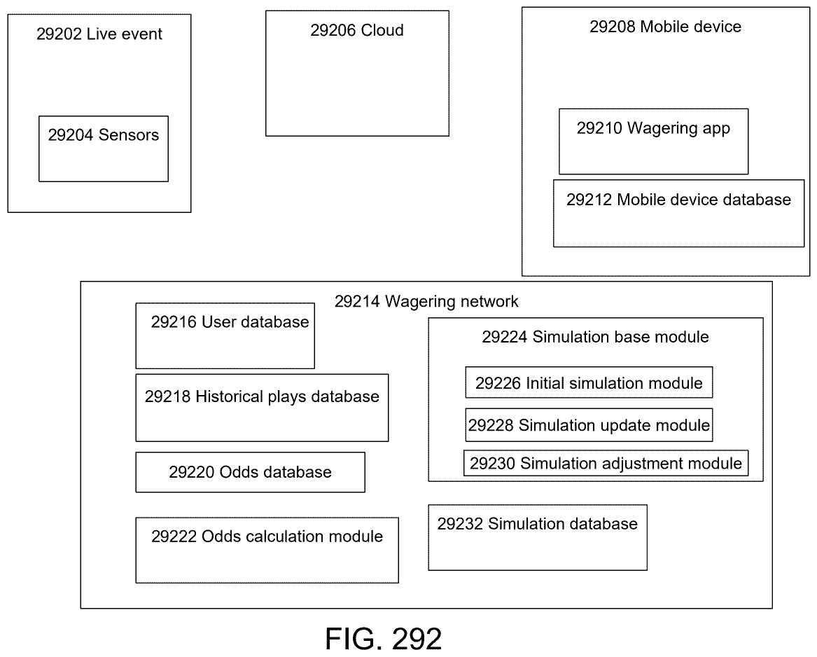

FIG. 292 illustrates a system for odds making through context-specific simulations, according to an embodiment.

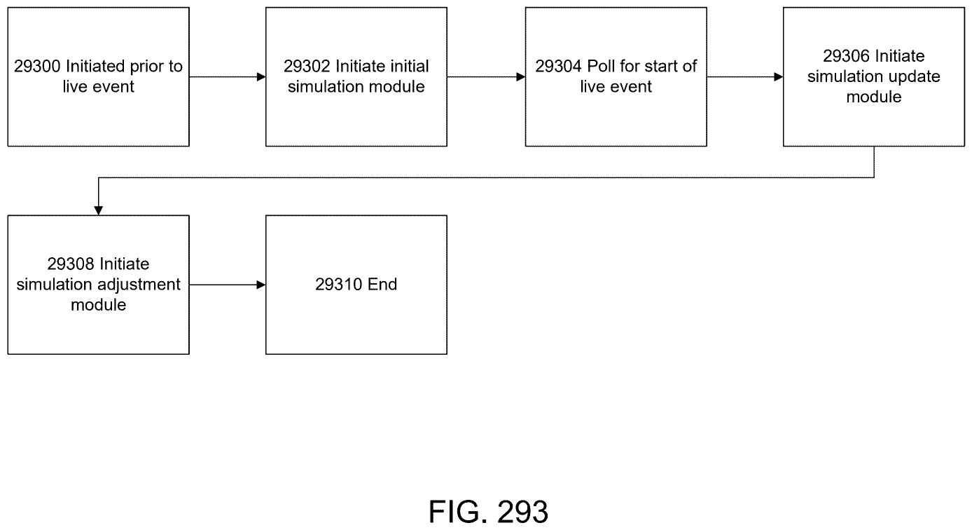

FIG. 293 illustrates a simulation base module, according to an embodiment.

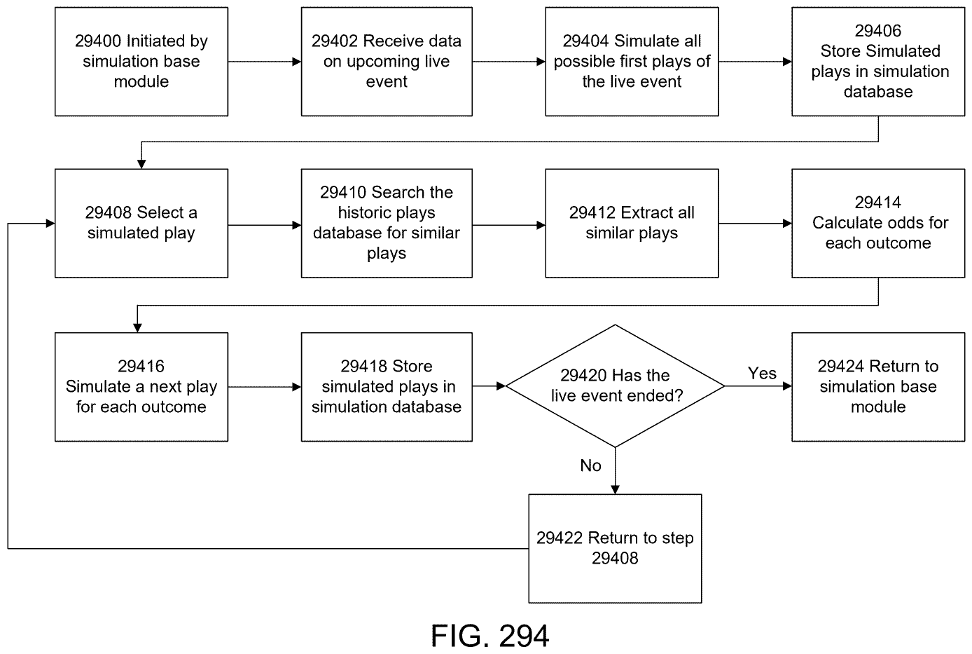

FIG. 294 illustrates an initial simulation module, according to an embodiment.

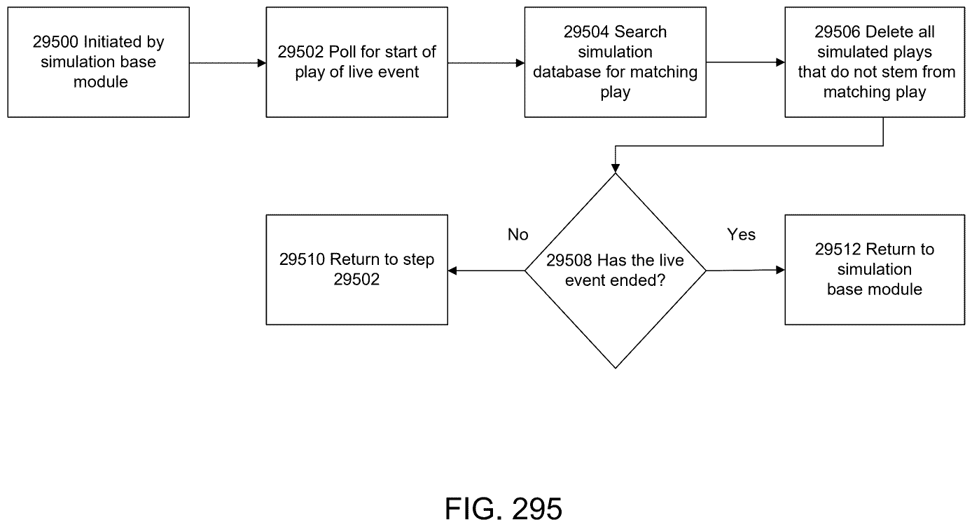

FIG. 295 illustrates a simulation update module, according to an embodiment.

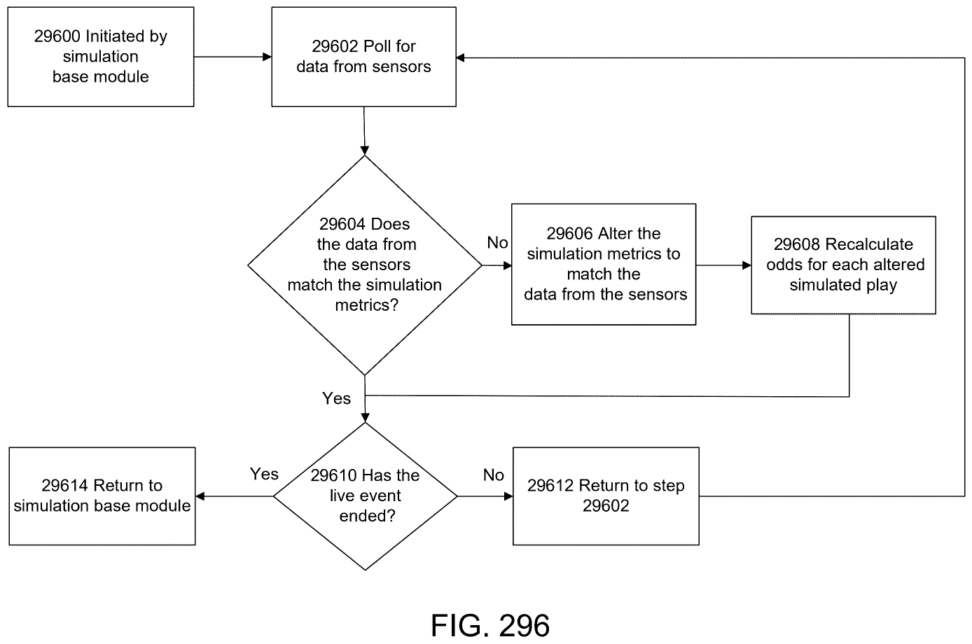

FIG. 296 illustrates a stimulation adjustment module, according to an embodiment.

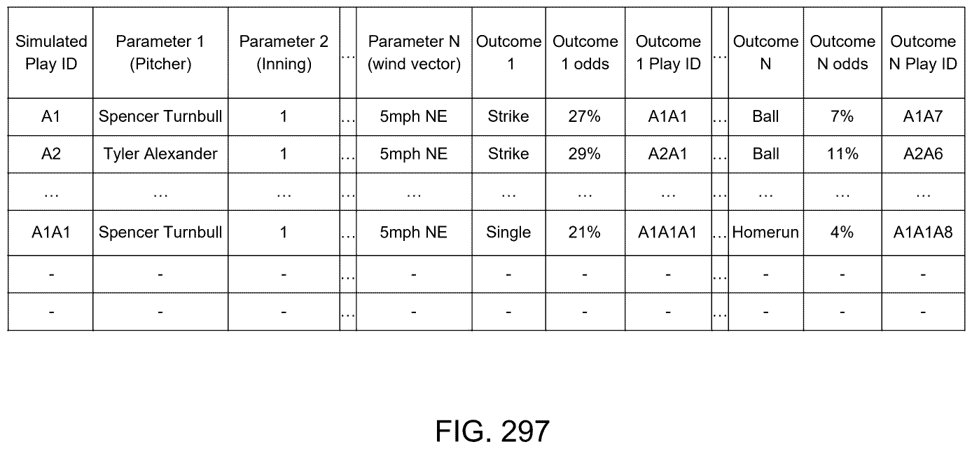

FIG. 297 illustrates a simulation database, according to an embodiment.

FIG. 292 is a system for odds making through context-specific simulations. This system may include a live event 29202, for example, a sporting event such as a football, basketball, baseball, or hockey game, tennis match, golf tournament, eSports or digital game, etc. The live event 29202 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 29202, such as the score of an American football game or the run line in a baseball game, or a series of actions in the live event 29202. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 29202 or at another location.

Further, embodiments may include a plurality of sensors 29204 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 29204 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 29206 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 29206 may be communicatively coupled to a peer-to-peer wagering network 29214, which may perform real-time analysis on the type of play and the result of the play. The cloud 29206 may also be synchronized with game situational data such as the time of the game, the score, location on the field, weather conditions, and the like, which may affect the choice of play utilized. For example, in an exemplary embodiment, the cloud 29206 may not receive data gathered from the sensors 29204 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 29208 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 29208 could be an optional component and would be utilized in a situation where a paired wearable device employs the mobile device 29208 for additional memory or computing power or connection to the internet.

Further, embodiments may include a wagering software application or a wagering app 29210, which is a program that enables the user to place bets on individual plays in the live event 29202, streams audio and video from the live event 29202, and features the available wagers from the live event 29202 on the mobile device 29208. The wagering app 29210 allows the user to interact with the wagering network 29214 to place bets and provide payment/receive funds based on wager outcomes.

Further, embodiments may include a mobile device database 29212 that may store some or all the user's data, the live event 29202, or the user's interaction with the wagering network 29214.

Further, embodiments may include the wagering network 29214, which may perform real-time analysis on the type of play and the result of a play or action. The wagering network 29214 (or the cloud 29206) may also be synchronized with game situational data, such as the time of the game, the score, location on the field, weather conditions, and the like, which may affect the choice of play utilized. For example, in an exemplary embodiment, the wagering network 29214 may not receive data gathered from the sensors 29204 and may, instead, receive data from an alternative data feed, such as SportsRadar®. This data may be provided substantially immediately following the completion of any play, and may be compared with a variety of team data and league data based on a variety of elements, including the current down, possession, score, time, team, and so forth, as described in various exemplary embodiments herein. The wagering network 29214 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 29216, which may contain data relevant to all users of the wagering network 29214 and may include, but is not limited to, a user ID, a device identifier, a paired device identifier, wagering history, or wallet information for the user. The user database 29216 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 29216 may contain betting lines and search queries. The user database 29216 may be searched based on a search criterion received from the user. Each betting line may include, but is not limited to, a plurality of betting attributes such as at least one of the live event 29202, a team, a player, an amount of wager, etc. The user database 29216 may include, but is not limited to, information related to all the users involved in the live event 29202. In one exemplary embodiment, the user database 29216 may include information for generating a user authenticity report and a wagering verification report. Further, the user database 29216 may be used to store user statistics like, but not limited to, the retention period for a particular user, frequency of wagers placed by a particular user, the average amount of wager placed by each user, etc.

Further, embodiments may include a historical plays database 29218 that may contain play data for the type of sport being played in the live event 29202. For example, in American Football, for optimal odds calculation, the historical play data may include metadata about the historical plays, such as time, location, weather, previous plays, opponent, physiological data, etc.

Further, embodiments may utilize an odds database 29220—that contains the odds calculated by an odds calculation module 29222—to display the odds on the user's mobile device 29208 and take bets from the user through the mobile device wagering app 29210.

Further, embodiments may include the odds calculation module 29222, which utilizes historical plays data to calculate odds for in-play wagers.

Further, embodiments may include a simulation base module 29224. The simulation base module 29224 may initiate an initial simulation module 29226 to create an initial simulation of the live event 29202 based on data in the historical plays database 29218. The simulation base module 29224 may initiate a simulation update module 29228 to update the initial simulation based on the current state of the live event 29202. The simulation base module 29224 may initiate a simulation adjustment module 29230 to adjust the initial simulation based on the variance between expected metrics and the reality of the live event 29202.

Further, embodiments may include the initial simulation module 29226, which may simulate a set of possible plays for the live event 29202 based on historical data. The simulated plays may be stored in a simulation database 29232.

Further, embodiments may include the simulation update module 29228, which may remove impossible outcomes from the initial simulation based on the current state of the live event 29202. For example, if the beginning coin flip of an American football game was heads, then all simulations where the result of the coin flip was tails may be discarded.

Further, embodiments may include the simulation adjustment module 29230, which may adjust the simulation based on the variance between predicted metrics and the reality of the live event 29202. For example, if a pitcher in a baseball game is pitching below or above their historical average, the simulation may adjust to compensate for the variance.

Further, embodiments may include the simulation database 29232, which may store the simulation created by the initial simulation module 29226. The simulation database may be accessed and altered by the simulation update module 29228. Data in the simulation database 132 may be used to calculate odds by the odds calculation module 29222.

FIG. 293 illustrates the simulation base module 29224. The process may begin with initiation of the simulation base module 29224, at step 29300, before the start of the live event 29202. The simulation base module 29224 may be initiated manually by an administrator of the system or another module. The simulation base module 29224 may be initiated once enough data has been collected to make accurate simulations, for example, when the player line-up for the live event 29202 is finalized. The simulation base module 29224 may initiate, at step 29302, the initial simulation module 29226. The initial simulation module 29226 may create a set of possible outcomes for each play of the live event 29202. The simulation base module 29224 may poll, at step 29304, for the start of the live event 29202. The simulation base module 29224 may initiate, at step 29306, the simulation update module 29228. The simulation update module 29228 may update the initial simulation based on the current state of the live event 29202. The simulation base module 29224 may initiate, at step 29308, the simulation adjustment module 29230. The simulation adjustment module 29230 may adjust the metrics used in the initial simulation based on how those metrics vary from the live event 29202. Changing the metrics may alter the odds of one or more simulated plays in the simulation database 29232. The simulation base module 29224 may end at step 29310. The simulation base module 29224 may wait for all initialized modules to return to the simulation base module 29224 before ending.

FIG. 294 illustrates the initial simulation module 29226. The process may begin with initiation of the initial simulation module 29226, at step 29400, by the simulation base module 29224. The initial simulation module 29226 may receive, at step 29402, data on the upcoming live event 29202. This data may be entered manually by an administrator, retrieved from a database, or sent by another module. The initial simulation module 29226 may simulate, at step 29404, all possible first plays of the live event 29202. The simulated plays may be possible states of the live event 29202 at the beginning of the first play. For example, if the live event 29202 is a baseball game, a possible first play may list the expected opening pitcher against the expected opening batter. Other possible plays may include listing a different pitcher against the expected opening batter or listing the expected opening pitcher against a different batter. The initial simulation module 29226 may store, at step 29406, the simulated plays in the simulation database 29232. The initial simulation module 29226 may select, at step 29408, a simulated play in the simulation database 29232. Simulated plays that occur earlier in the live event 29202 may be prioritized. For example, the initial simulation module 29226 may not select a second play of the live event 29202 until all simulated first plays have been selected. The initial simulation module 29226 may search, at step 29410, the historical plays database 29218 for plays with parameters similar to the selected simulated play of the live event 29202. The similar parameters may not have to be an exact match. For example, two plays with the same team and players may be considered similar even though the weather may differ. A similar play may be one in which players with similar traits participated. For example, a similar play may be defined as the current pitcher against other left-handed batters or the current pitcher against left-handed batters with a normalized on-base plus slugging percentage (OPS+) between 29205 and 29215, or within one standard deviation of the current batter. Identifying cohorts of players with similar characteristics may allow the system to examine a larger sample size of data related to other context characteristics of the play, such as temperature, park factor, wind direction, etc. An administrator of the system or another module may adjust which plays are considered similar. The initial simulation module 29226 may extract, at step 29412, all similar plays from the historical plays database 29218. The initial simulation module 29226 may calculate, at step 29414, odds for the outcome of the simulated play using the extracted similar plays. For example, if 100 similar plays are extracted and 27 resulted in a strike, while the other 73 resulted in another outcome, the odds for a strike would be calculated as 27%. The initial simulation module 29226 may simulate, at step 29416, a next play of the live event 29202 for each outcome. For example, if an outcome of the first play of the game is a strike, then the simulated second play of the game may have all the same parameters except that the number of strikes would be increased by one. Other parameters such as time, temperature, wind speed, etc., may be estimated based on the average time of a play and the amount each parameter may change from play to play. Outcomes with a minute chance of occurring, for example, <1%, may be excluded. The initial simulation module 29226 may store, at step 29418, the simulated plays in the simulation database 29232. The initial simulation module 29226 may determine, at step 29420, if the live event 29202 has ended by obtaining data from the sensors 29204 or as manually determined by an administrator. The initial simulation module 29226 may check if the live event 29202 has ended after each prior step. The initial simulation module 29226 may also determine if there are no more plays to simulate. If the live event 29202 has not ended, the initial simulation module 29226 may return, at step 29422, to step 29408. The initial simulation module 29226 may return, at step 29424, to the simulation base module 29224.

FIG. 295 illustrates the simulation update module 29228. The process may begin with the simulation update module 29228 being initiated, at step 29500, by the simulation base module 29224. The simulation update module 29228 may poll, at step 29502, for the start of a play of the live event 29202. This information may be obtained from the sensors 29204 at the live event 29202. The simulation update module 29228 may search, at step 29504, the simulation database 29232 for a simulated play that matches the actual state of the live event 29202. A matched play may not require the same parameters to be considered as a match. For example, if all of a play's parameters except wind speed match, but wind speed is within two mph of the simulated wind speed, it may be considered as a match. If more than one play is a match, the simulation update module 29228 may select the simulated play that closely matches the live event 29202. The simulation update module 29228 may delete, at step 29506, all simulated plays in the simulation database 29232 that do not stem from the matching play. This is done by checking which simulated play IDs omit the matching simulated play ID. For example, if the matching play ID is A2, then simulated plays with a simulated play ID that does not begin with A2 may be discarded. The simulation update module 29228 may determine, at step 29508, if the live event 29202 has ended by obtaining information from the sensors 29204 at the live event 29202. If the live event 29202 has not ended, the simulation update module 29228 may return, at step 29510, to step 29502. If the live event 29202 has ended, the simulation update module 29228 may return, at step 29512, to the simulation base module 29224.

FIG. 296 illustrates the simulation adjustment module 29230. The process may begin with the simulation adjustment module 29230 being initiated, at step 29600, by the simulation base module 29224. The simulation adjustment module 29230 may poll, at step 29602, for data from the sensors 29204 at the live event 29202. The simulation adjustment module 29230 may determine, at step 29604, if the data from the sensors 29204 matches the metrics used to simulate plays. For example, if the initial simulation module 29226 used historical weather data to predict an average wind vector of five mph NE for the first inning of a baseball game and the data from the sensors 29204 indicates that the actual wind vector is ten mph SE, the simulation adjustment module 29230 may determine that this is not a match. The match may not need to be an exact match. The simulation adjustment module 29230 may ignore insignificant discrepancies, such as a one mph wind speed difference. The simulation adjustment module 29230 may require a collection of data over several plays-which show consistent differences between the collected data from the sensors 29204 and the metrics used to simulate plays—to determine the absence of a match. Differences between discrete outcomes, such as the player at-bat, the pitcher, the loaded bases, etc., are handled by the simulation update module 29228. The simulation adjustment module 29230 may alter, at step 29606, the metrics to match the data from the sensors 29204 if the simulation metrics and data from the sensors 29204 do not match. For example, if all the possible simulated plays use a wind vector of five mph NE, but the actual wind vector is ten mph SE, then the simulated plays may be altered to have a wind vector of ten mph SE in the simulation database 29232. Simulated plays that have been discarded by the simulation update module 29228 may be ignored. The simulation adjustment module 29230 may recalculate, at step 29608, the odds for each simulated play whose metrics were changed. The altered simulated plays may be marked as new simulated plays, and the recalculation may be done by the initial simulation module 29226. Alternatively, the simulation adjustment module 29230 may calculate the odds and alter those values in the simulation database 29232. The simulation adjustment module 29230 may use the same method of calculating odds as the initial simulation module 29226. If the simulation metrics and data from the sensors 29204 match, the simulation adjustment module 29230 may determine, at step 29610, if the live event 29202 has ended. This data may be obtained from the sensors 29204 at the live event 29202. If the live event 29202 has not ended, the simulation adjustment module 29230 may return, at step 29612, to step 29602. If the live event 29202 has ended, the simulation adjustment module 29230 may return, at step 29614, to the simulation base module 29224.

FIG. 297 illustrates the simulation database 29232. The simulation database 29232 may contain data on simulated plays, which may be originally populated by the initial simulation module 29226 and may later be altered by the simulation update module 29228 and/or simulation adjustment module 29230. The simulation database 29232 may contain a simulated play ID that identifies the simulated play and may also incorporate the simulated play ID of the prior simulated play. For example, the simulated play ID, “A1A1”, contains the simulated play ID, “A1”, and the simulated play ID, “A1”, of the last play. The simulation database 29232 may contain the parameters of the simulated play used by the initial simulation module 29226 to calculate the odds of each outcome. These parameters may be altered by the simulation adjustment module 29230 to reflect the reality of the live event 29202. The simulation database 29232 may contain several possible outcomes—with their respective odds—for the simulated play, as well as the simulated play ID of the simulated play that may result from the outcome.

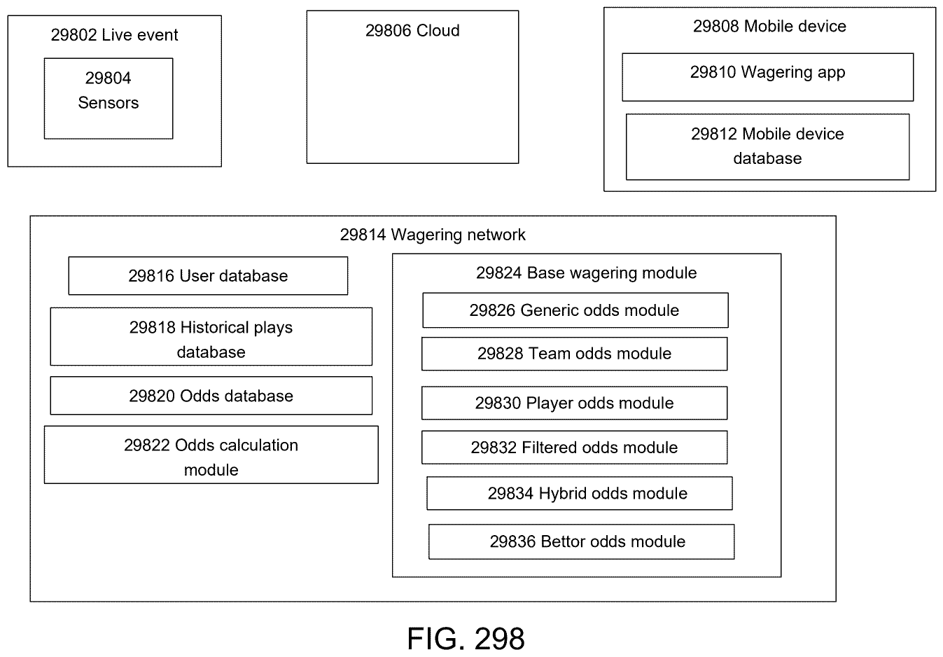

FIG. 298: Illustrates a system for voice-based wagering, according to an embodiment.

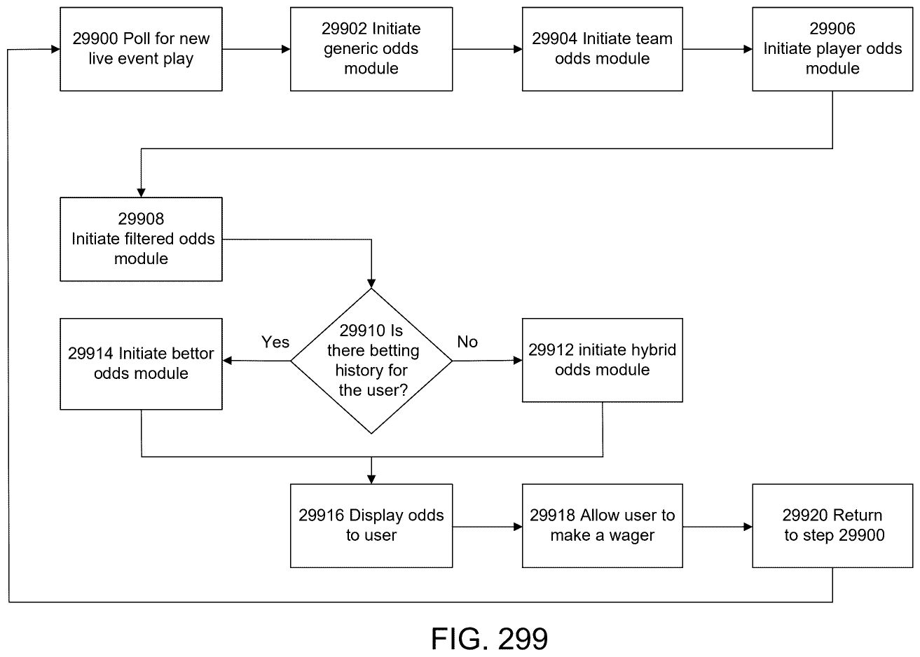

FIG. 299: Illustrates a base wagering module, according to an embodiment.

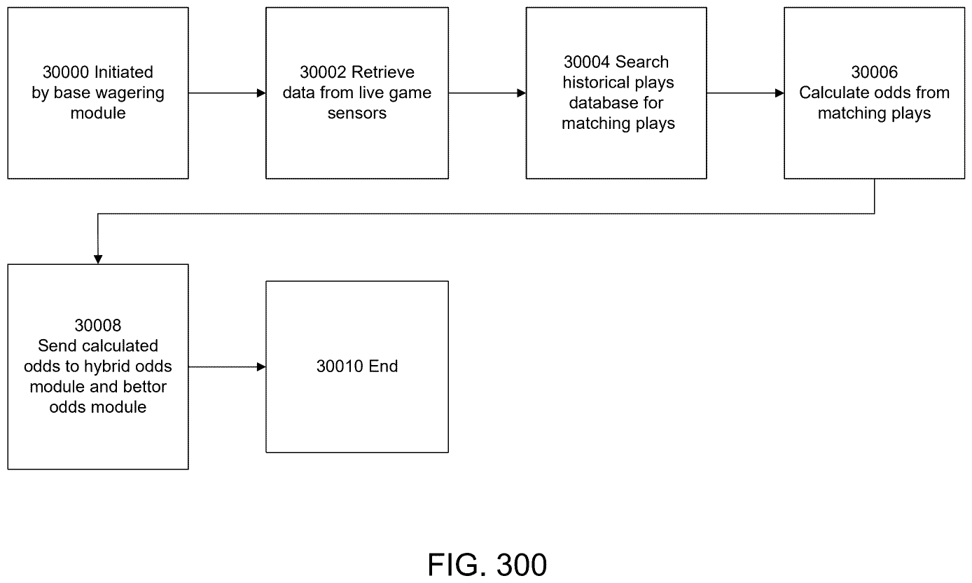

FIG. 300: Illustrates a generic odds module, according to an embodiment.

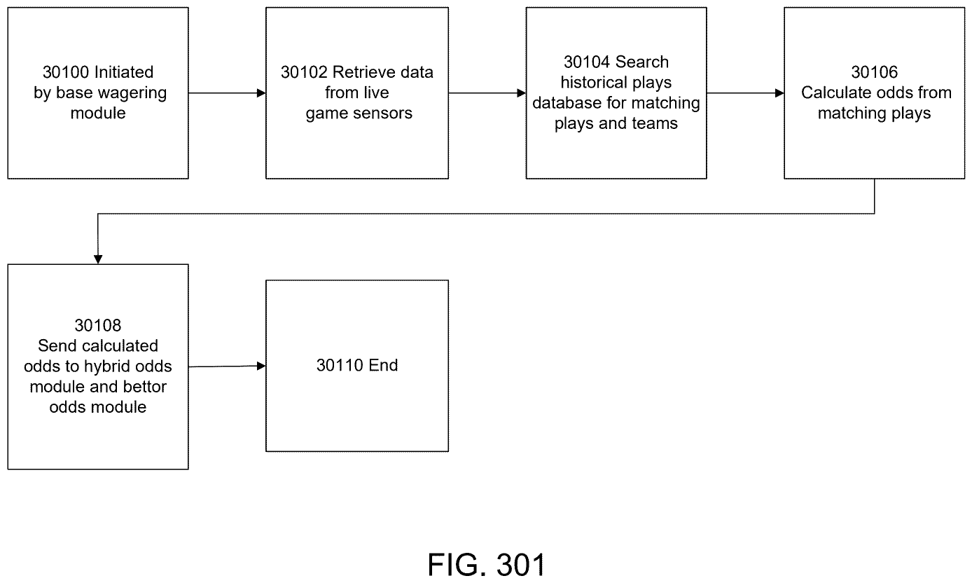

FIG. 301: Illustrates a team odds module, according to an embodiment.

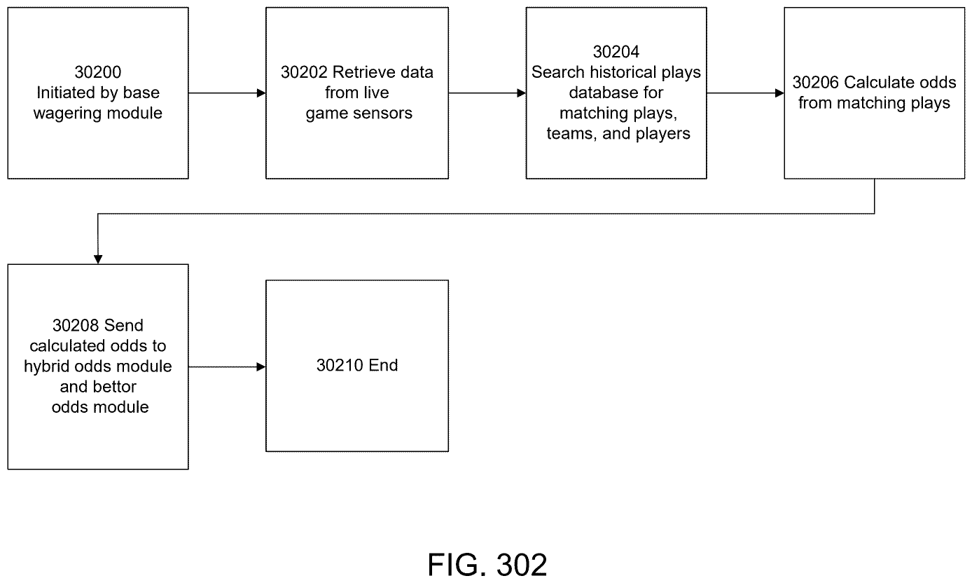

FIG. 302: Illustrates a player odds module, according to an embodiment.

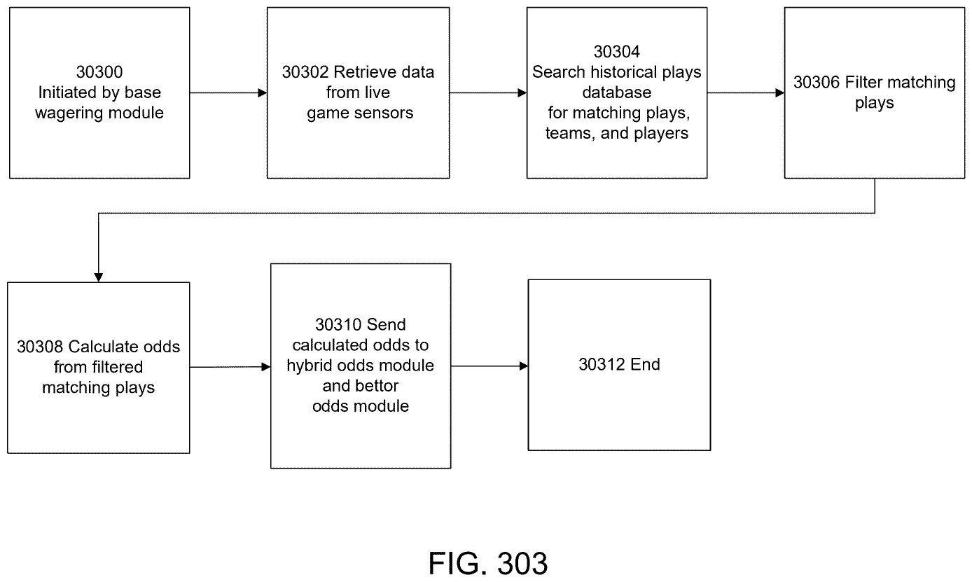

FIG. 303: Illustrates a filtered odds module, according to an embodiment.

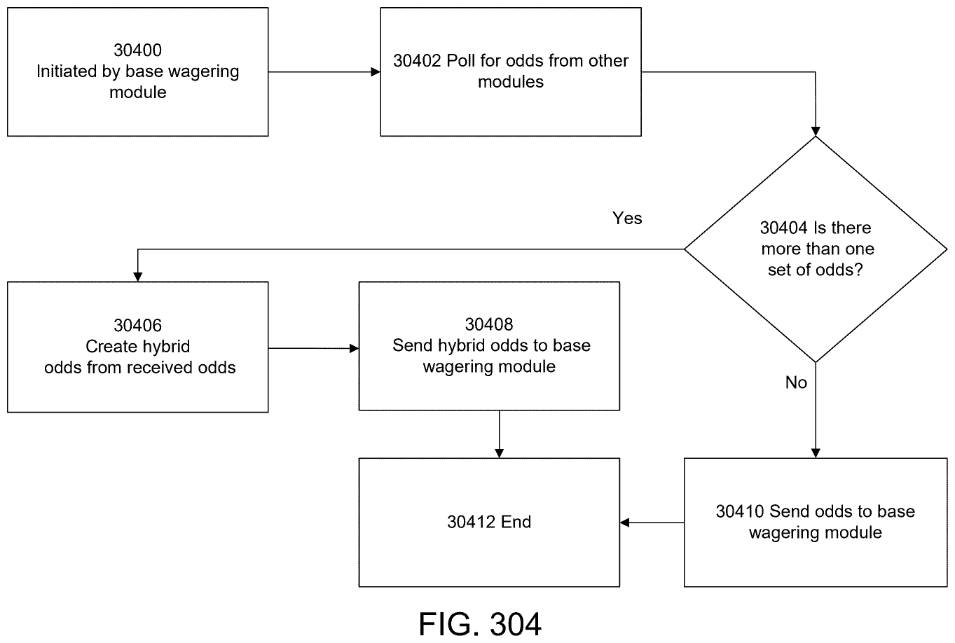

FIG. 304: Illustrates a hybrid odds module, according to an embodiment.

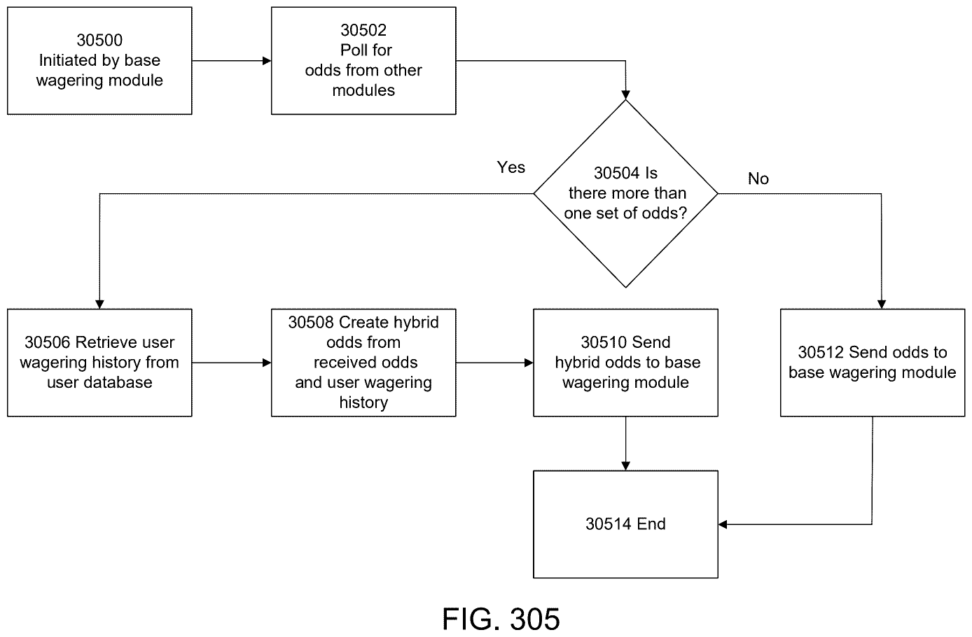

FIG. 305: Illustrates a bettor odds module, according to an embodiment.

FIG. 298 is a system for voice-based wagering. This system may include a live event 29802, for example, a sporting event such as a football game, basketball game, baseball game, hockey game, tennis match, golf tournament, eSports or digital game, etc. The live event 29802 will include some number of actions or plays, upon with a user or bettor or customer can place a bet or wager, typically through an entity called a sportsbook. There are numerous types of wagers the bettor can make, including, but not limited to, a straight bet, a money line bet, a bet with a point spread or line that the bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk. This is typically applied to round-robin or other tournaments' styles. There are other types of wagers, including parlays, teasers, and prop bets, that are added games that often allow the user to customize their betting by changing the odds and payouts they receive on a wager. Certain sportsbooks will allow the bettor to buy points to move the point spread off of the opening line. This will increase the price of the bet, sometimes by increasing the juice, vig, or hold that the sportsbook takes. Another type of wager the bettor can make is an over/under, in which the user bets over or under a total for the live event 29802, such as the score of an American football game or the run line in baseball, or a series of actions in the live event 29802. Sportsbooks have several bets they can handle, which can be a limit of wagers they can take on either side of a bet before they will move the line or odds off of the opening line. Additionally, there are circumstances, such as an injury to an important player such as a listed pitcher, in which a sportsbook, casino, or racino will take an available wager off the board. As the line moves, there becomes an opportunity for a bettor to bet on both sides at different points, in order to middle and win both bets. Sportsbooks will often offer bets on portions of games, such as first-half bets and half-time bets. Additionally, the sportsbook can offer futures bets on live events 29802 in the future. Sportsbooks need to offer payment processing services in order to cash out customers. This can be done at kiosks at the live event 29802 or at another location.

Further, embodiments may include a plurality of sensors 29804 that may be used such as motion sensors, temperature sensors, humidity sensors, optical sensors and cameras, such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices, etc. Also, the plurality of sensors 29804 may include tracking devices, such as RFID tags, GPS chips, or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 29806 or a communication network that may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), radio waves, and other communication techniques are known in the art. The communication network may allow ubiquitous access to shared pools of configurable system resources and higher-level services that can be rapidly provisioned with minimal management effort, often over the internet, and relies on sharing of resources to achieve coherence and economics of scale, like a public utility. In contrast, third-party clouds allow organizations to focus on their core businesses instead of expending resources on computer infrastructure and maintenance. Cloud 29806 may be communicatively coupled to peer-to-peer wagering network 29814, which may perform real-time analysis on the type of play and the result of the play. The cloud 29806 may also be synchronized with game situational data, such as the time of the game, the score, location on the field, weather conditions, and the like, which may affect the choice of play utilized. For example, in other exemplary embodiments, the cloud 29806 may not receive data gathered from sensors 29804 and may, instead, receive data from an alternative data feed, such as Sports Radar®. This data may be compiled substantially immediately following the completion of any play, and the data from this feed may be compared with a variety of team data and league data based on a variety of elements, including down, possession, score, time, team, and so forth, as described in various exemplary embodiments herein.

Further, embodiments may include a mobile device 29808 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs by combining some of the inputs and outputs. Some devices allow for facial recognition, which may be utilized as an input for different purposes, including authentication and other commands. Some devices provide for voice recognition and inputs, including, e.g., Microsoft KINECT, SIRI for iPhone by Apple, Google Now, or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality, including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices, or group of devices may be augmented reality devices. An I/O controller may control the I/O devices. The I/O controller may control one or more I/O devices, such as e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g., a USB bus, a SCSI bus, a FireWire bus, an Ethernet bus, a Gigabit Ethernet bus, a Fiber Channel bus, or a Thunderbolt bus. In some embodiments, the mobile device 29808 could be an optional component and would be utilized in a situation where a paired wearable device utilizes the mobile device 29808 as additional memory or computing power or connection to the internet.

Further, embodiments may include a wagering software application or wagering app 29810, which is a program that enables the user to place bets on individual plays in the live event 29802 and displays the audio and video from the live event 29802, along with the available wagers on the mobile device 29808. The wagering app 29810 allows the user to interact with the wagering network 29814 to place bets and provide payment/receive funds based on wager outcomes.

Further, embodiments may include a mobile device database 29812 that may store some or all of the user's data, the live event 29802, or the user's interaction with the wagering network 29814.

Further, embodiments may include the wagering network 29814, which may perform real-time analysis on the type of play and the result of a play or action. The wagering network 29814 (or cloud 29806) may also be synchronized with game situational data, such as the time of the game, the score, location on the field, weather conditions, and the like, which may affect the choice of play utilized. For example, in some exemplary embodiments, the wagering network 29814 may not receive data gathered from sensors and may, instead, receive data from an alternative data feed, such as SportsRadar®. This data may be provided substantially immediately following the completion of any play, and the data from this feed may be compared with a variety of team data and league data based on a variety of elements, including down, possession, score, time, team, and so forth, as described in various exemplary embodiments herein. The wagering network 29814 can offer several software as a service managed services such as user interface service, risk management service, compliance, pricing and trading service, IT support of the technology platform, business applications, game configuration, state-based integration, fantasy sports connection, integration to allow the joining of social media, as well as marketing support services that can deliver engaging promotions to the user.

Further, embodiments may include a user database 29816, which may contain data relevant to users of the wagering network 29814, which may include, but is not limited to, a user ID, a device identifier, a paired device identifier, wagering history, and wallet information for the user. The user database 29816 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 29816 may contain betting lines and search queries. The user database 29816 may be searched based on a search criterion received from the user. Each betting line may include a plurality of betting attributes such as at least one of the live event 29802, a team, a player, an amount of wager, etc. The user database 29816 may include information related to all the users involved in the live event 29802. In one example embodiment, the user database 29816 may include information for generating a user authenticity report and a wagering verification report. Further, the user database 29816 may be used to store user statistics including, but not limited to, the retention period for a particular user, frequency of wagers placed by a particular user, or the average amount of wager placed by each user.

Further, embodiments may include a historical play database 29818 that may contain play data for the type of sport being played in the live event 29802. For example, in American Football, for optimal odds calculation, the historical play data may include metadata about the historical plays, such as time, location, weather, previous plays, opponent, physiological data, etc.

Further, embodiments may utilize an odds database 29820 that contains the odds calculated by an odds calculation module 29822 to display the odds on the user's mobile device 108 and to take bets from the user through the mobile device wagering app 29810.

Further, embodiments may include the odds calculation module 29822, which utilizes historical play data to calculate odds for in-play wagers

Further, embodiments may include a base wagering module 29824, which may allow the user to place wagers on the live event 29802. The module initiates a generic odds module 29826, a team odds module 29828, a player odds module 29830, a filtered odds module 29832, a hybrid odds module 29834, and a bettor odds module 29836.

Further, embodiments may include the generic odds module 29826, which may be executed by receiving data about the current play in the live event 29802 and then determining the next play and the odds of the next play in advance to make the system more efficient and to provide the player of the game insight into the next play in order to get the player to bet on the current play and/or the next play. For example, if there are two outs in a baseball game, and a batter has two strikes and no balls, the next pitch could lead to only several conclusions, e.g., another strike or out ends the inning, or the inning continues because there is a ball called or a hit or a foul. The odds of each next possibility can be calculated based on averages of some or all games in the historical plays database 29818. This is useful as baseline odds calculations, particularly if there are issues with more specific analysis, such as heavy weather affecting the precise analysis of the players and both teams. It should be noted that the odds calculations can be a simple average, or it could be an average of a subset of all the data, where the subset is chosen from filtering out data to make the average closer to the norm, such as filtering out abnormal games (e.g., lasted more than ten innings, etc.).

Further, embodiments may include the team odds module 29828, which may be executed by receiving data about the current play in the live event 29802 and then determining the next play and the odds of the next play in advance to make the system more efficient and to provide the user of the system insight into the next play in order to get the user to bet on the current play and/or the next play. For example, if there are two outs in a baseball game, and a count is no balls and two strikes, the next pitch could lead to only several conclusions, e.g., another strike or an out would end the inning, or the inning may continue if there is a ball called, or a hit, or a foul. The odds of each next possible outcome may be calculated based on averages of some or all games between these two teams in the historical plays database 29818. This is useful as baseline odds calculations, as they are likely to be more accurate than odds calculated from generic history data. It should be noted that calculated odds could be based upon correlation calculations, such as but not limited to regression analysis, that is, if one of the possibilities of the next play is a walk, from 2 outs and two strikes, the frequency of a “walk” is for example 20% for all games, 25% for a score of 2 to 1, 30% for a score 3 to 1, 28% for a no players on base, 32% for three players on base, etc., so by evaluation each of these percentages for many give cases, a best fit regression is 28.5% with a correlation coefficient of 95% which is enough confidence to suggest odds based upon 28.5% probability. This is just one example of how odds may be calculated.

Further, embodiments may include the player odds module 29830, which may be executed by receiving data about the current play in the live event 29802 and then determining the possible contexts of the next play and the odds of at least one potential outcome of the next play, in advance to make the system more efficient and to provide the user of the game insight into the next play in order to get the user to bet on the current play and/or the next play. For example, if there are two outs in a baseball game, and the count is no balls and two strikes, the next pitch could lead to only several conclusions, e.g., another strike or an out ends the inning, or the inning may continue if there is a ball called, or a hit, or a foul. The odds of each next possibility may be calculated based on averages of some or all games ever played between these two teams playing as well as the historical interactions between a given pitcher and a given batter in the historical plays database 29818. This is useful as baseline odds calculations, as they are likely to be more accurate than calculated odds from generic history data and likely more accurate than calculated odds from team history data. It should be noted that calculated odds could be based upon correlation calculations, such as but not limited to regression analysis, that is, if one of the possibilities of the next play is a walk, from 2 outs and two strikes, the frequency of a “walk” is for example 20% for all games, 25% for a score of 2 to 1, 30% for a score 3 to 1, 28% for a no players on base, 32% for three players on base, etc., so by evaluation each of these percentages for many give cases, a best fit regression is 28.5% with a correlation coefficient of 95% which is enough confidence to suggest odds based upon 28.5% probability. This is just one example of how odds may be calculated.

Further, embodiments may include the filtered odds module 29832, which may be executed by receiving data about the current play in the live event 29802 and then determining the next play and the odds of the next play in advance to make the system more efficient and to provide the player of the game insight into the next play in order to get the player to bet on the current play and/or the next play. For example, if there are two outs in a baseball game, and the count no balls and two strikes, the next pitch could lead to only several conclusions, e.g., another strike, or out ends the inning, or the inning may continue because there is a ball called, or there is a hit or a foul. The odds of each next possibility can be calculated based on averages of all games ever played between these two teams playing as well as the odds from the history of the given pitcher and the given batter which in the past as well as adding a further filter, such as geolocation, weather, etc. which are in a database. This is useful as a baseline odds calculations, as they are likely to be more accurate than calculated odds from generic history data, likely more accurate than calculated odds from team history data, and likely be more accurate than calculated odds from teams and the particular players on the teams' historical data. It should be noted that calculated odds could be based upon correlation calculations, such as but not limited to regression analysis, that is, if one of the possibilities of the next play is a walk, from 2 outs and two strikes, the frequency of a “walk” says 20% for all games, 25% for a score of 2 to 1, 30% for a score 3 to 1, 28% for a no players on base, 32% for three players on base, etc., so by evaluating each of these percentages for many cases, a best fit regression is 28.5% with a correlation coefficient of 95% which is enough confidence to suggest odds based upon 28.5% probability. This is just one example of how odds may be calculated.

Further, embodiments may include the hybrid odds module 29834, which may be executed by receiving odds from the other odds calculation module 29822 and then determining the next play and the odds of the next play in advance to make the system more efficient and to provide the player of the game insight into the next play in order to get the player to bet on the current play and/or the next play. For example, if there are two outs in a baseball game, and the count no balls and two strikes, the next pitch could lead to only several conclusions, e.g., another strike, or out ends the inning, or the inning may continue because there is a ball called, or there is a hit or a foul. The odds of each next possibility can be calculated based upon running the analysis of the generic odds module 29826, the team odds module 29828, the player odds module 29830, and the filtered odds module 29832, then determining if they are within a certain range to offer the least risky odds. It should be noted that calculated odds could be based upon correlation calculations, such as but not limited to regression analysis, that is, if one of the possible outcomes of the next play is a walk, from 2 outs and two strikes, the frequency of a “walk” is for example 20% for all games, 25% for a score of 2 to 1, 30% for a score 3 to 1, 28% for a no players on base, 32% for three players on base, etc., so by evaluation each of these percentages for many give cases, a best fit regression is 28.5% with a correlation coefficient of 95% which is enough confidence to suggest odds based upon 28.5% probability. This is just one example of how odds may be calculated.

Further, embodiments may include the bettor odds module 29836, which may be executed by receiving odds from the other odds calculation modules 29822 and then determining the next play and the odds of the next play in advance to make the system more efficient and to provide the player of the game insight into the next play in order to get the player to bet on the current play and/or the next play. For example, if there are two outs in a baseball game, and the count is no balls and two strikes, the next pitch could lead to only several conclusions, e.g., another strike, or out ends the inning, or the inning may continue because there is a ball called, or a hit, or a foul. The odds of each next possibility can be calculated based upon running the analysis of the generic odds module 29826, the team odds module 29828, the player odds module 29830, and the filtered odds module 29832, then determining if they are within a certain range to offer the least risky odds as well as including the performance of the bettor. So, a bettor that is winning a larger percentage of the time might be given lower odds than one who is losing more frequently. This allows for expertise currently vs. past data expertise. It should be noted that calculated odds could be based upon correlation calculations, such as but not limited to regression analysis, that is, if one of the possibilities of the next play is a walk, from 2 outs and two strikes, the frequency of a “walk” is for example 20% for all games, 25% for a score of 2 to 1, 30% for a score 3 to 1, 28% for a no players on base, 32% for three players on base, etc., so by evaluation each of these percentages for many give cases, a best fit regression is 28.5% with a correlation coefficient of 95% which is enough confidence to suggest odds based upon 28.5% probability. This is just one example of how odds may be calculated.

FIG. 299 illustrates the base wagering module 29824. The process begins with the base wagering module 29824 polling, at step 29900, for a new play of the live event 29802. The base wagering module 29824 initiates, at step 29902, the generic odds module 29826. The base wagering module 29824 initiates, at step 29904, the team odds module 29828. The base wagering module 29824 initiates, at step 29906, the player odds module 29830. The base wagering module 29824 initiates, at step 29908, the filtered odds module 29832. The base wagering module 29824 determines, at step 29910, if there is betting history data for the user in the user database 29816. If there is no historical betting data on the user, the base wagering module 29824 initiates, at step 29912, the hybrid odds module 29834. If there is historical betting data on the user, the base wagering module 29824 initiates, at step 29914, the bettor odds module 29836. The base wagering module 29824 displays, at step 29916, the odds to the user via the wagering app 29810. The odds may be obtained by the base wagering module 29824 from the hybrid odds module 29834 or the bettor odds module 29836. The base wagering module 29824 allows, at step 29918, the user to place a wager. The wager may be placed via the wagering app 29810 and stored in a database, for example, the user database 29816. The base wagering module 29824 returns, at step 29920, to step 29900.

FIG. 300 illustrates the generic odds module 29826. The process begins with the generic odds module 29826 being initiated at step 30000 by the base wagering module 29824. The generic odds module 29826 retrieves, at step 30002, data from the live event 29802 via the sensors 29804. The generic odds module 29826 searches, at step 30004, the historical plays database 29818 for plays that match the data retrieved from the live event 29802. For example, there are two outs in a baseball game, and the count is no balls and two strikes; the generic odds module 29826 may search for plays with the same or similar conditions. The generic odds module 29826 calculates, at step 30006, the odds for the potential outcomes of the current play of the live event 29802. The odds for each potential outcome may be calculated by determining the outcome's frequency for all matching plays. For example, 100 matching plays are found. The outcome of 25 of the matching plays were “outs,” and 75 were not “outs.” The calculated odds for the outcome of the current play to be an “out” would be 25%, 1 in 4, or 1:4. The generic odds module 29826 sends, at step 30008, the calculated odds to the hybrid odds module 29834 or the bettor odds module 29836. The generic odds module 29826 may determine which module is active and send the odds to that module, or may just send the odds to both. The generic odds module 29826 ends at step 30010.

FIG. 301 illustrates the team odds module 29828. The process begins with the team odds module 29828 being, at step 30100, initiated by the base wagering module 29824. The team odds module 29828 retrieves, at step 30102, data from the live event 29802 via the sensors 29804. The team odds module 29828 searches, at step 30104, the historical plays database 29818 for plays and teams that match the data retrieved from the live event 29802. For example, there are two outs in a baseball game, and the count is no balls and two strikes in a game between the Angels and the Dodgers. The team odds module 29828 will search for plays with the same or similar conditions. The team odds module 29828 calculates, at step 30106, odds for the outcome of the current play of the live event 29802. Each outcome's odds may be calculated by determining the frequency of that outcome for all matching plays. For example, 100 matching plays are found. The outcome of 25 of the matching plays were “outs,” and 75 were not “outs.” The calculated odds for the outcome of the current play to be an “out” would be 25%, 1 in 4, or 1:4. The team odds module 29828 sends, at step 30108, the calculated odds to the hybrid odds module 29834 or the bettor odds module 29836. The team odds module 29828 may determine which module is active and send the odds to that module, or may just send the odds to both. The team odds module 29828 ends at step 30110.

FIG. 302 illustrates the player odds module 29830. The process begins with the player odds module 29830 being initiated at step 30200 by the base wagering module 29824. The player odds module 29830 retrieves, at step 30202, data from the live event 29802 via the sensors 29804. The player odds module 29830 searches, at step 30204, the historical plays database 29818 for plays, teams, and players that match the data retrieved from the live event 29802. For example, there are two outs in a baseball game, and the count is no balls and two strikes in a game between the Angels and the Dodgers. David Fletcher is at-bat, and Dustin May is pitching. The player odds module 29830 will search for plays with the same or similar conditions. The player odds module 29830 calculates, at step 30206, odds for the outcome of the current play of the live event 29802. Each outcome's odds may be calculated by determining the frequency of that outcome for all matching plays. For example, 100 matching plays are found. The outcome of 25 of the matching plays were “outs,” and 75 were not “outs.” The calculated odds for the outcome of the current play to be an “out” would be 25%, 1 in 4, or 1:4. The player odds module 29830 sends, at step 30208, the calculated odds to the hybrid odds module 29834 or the bettor odds module 29836. The player odds module 29830 may determine which module is active and send the odds to that module, or may just send the odds to both. The player odds module 29830 ends at step 30210.

FIG. 303 illustrates the filtered odds module 29832. The process begins with the filtered odds module 29832 being initiated at step 30300 by the base wagering module 29824. The filtered odds module 29832 retrieves, at step 30302, data from the live event 29802 via the sensors 29804. The filtered odds module 29832 searches, at step 30304, the historical plays database 29818 for plays, teams, and players that match the data retrieved from the live event 29802. For example, there are two outs in a baseball game, and the count is no balls and two strikes in a game between the Angels and the Dodgers. David Fletcher is at-bat, and Dustin May is pitching. The filtered odds module 29832 will search for plays with similar conditions in the historical plays database 29818. The filtered odds module 29832 filters, at step 30306, the matching plays based on filtering criteria such as geolocation, weather, time, etc. For example, if the filter is geolocation within 100 miles, all plays from outside 100 miles of the live event 29802 may be excluded from the odds calculation. The filter may be set manually or automatically. Appropriate filters may be determined using an AI-based module. Multiple instances of the filtered odds module 29832 may run simultaneously with different filtering criteria. The filtered odds module 132 calculates, at step 30308, odds for the outcome of the current play of the live event 29802. Each outcome's odds may be calculated by determining the frequency of that outcome for all matching plays. For example, 100 matching plays are found. The outcome of 25 of the matching plays were “outs,” and 75 were not “outs.” The calculated odds for the outcome of the current play to be an “out” would be 25%, 1 in 4, or 1:4. The filtered odds module 29832 sends, at step 30310, the calculated odds to the hybrid odds module 29834 or the bettor odds module 29836. The filtered odds module may determine which module is active and send the odds to that module, or may just send the odds to both. The filtered odds module 29832 ends at step 30320.

FIG. 304 illustrates the hybrid odds module 29834. The process begins with the hybrid odds module 29834 being, at step 30400, initiated by the base wagering module 29824. The hybrid odds module 29834 polls, at step 30402, for odds from the generic odds module 29826, team odds module 29828, player odds module 29830, and filtered odds module 29832. The hybrid odds module 29834 may wait a set amount of time after the first set of odds has been received before moving on to step 30404. Sets of odds that take too long to generate may not be included in the hybrid odds calculation for the current play of the live event 29802. The hybrid odds module 29834 determines, at step 30404, if more than one set of odds was received. If more than one set of odds was received, the hybrid odds module 29834 creates, at step 30406, hybrid odds based on the received odds. Hybrid odds may be generated by averaging all of the received sets of odds, selecting the lowest risk set of odds, selecting the most accurate set of odds, averaging a subset of the received odds, etc. For example, if the hybrid odds generation method is the average of all received odds, and the received odd for the outcome to be an “out” are 1:3 odds and 1:4 odds, then the hybrid odds for the outcome to be an “out” would be 1:3.5 or 2:7. The hybrid odds module 29834 sends, at step 30408, the created hybrid odds to the base wagering module 29824. If only one set of odds was received, the hybrid odds module 29834 sends, at step 30410, the received odds to the base wagering module 29824. The hybrid odds module ends at step 30412.

FIG. 305 illustrates the bettor odds module 29836. The process begins with the bettor odds module 29836 being, at step 30500, initiated by the base wagering module 29824. The bettor odds module 29836 polls, at step 30502, for odds from the generic odds module 29826, the team odds module 29828, the player odds module 29830, and the filtered odds module 29832. The bettor odds module 29836 may wait a set amount of time after the first set of odds has been received before moving on to step 30504. Sets of odds that take too long to generate may not be included in the hybrid odds calculation for the current play of the live event 29802. The bettor odds module 29836 determines, at step 30504, if more than one set of odds was received. If more than one set of odds was received, the bettor odds module 29836 retrieves, at step 30506, the user's wagering history from the user database 29816. The bettor odds module 29836 creates, at step 30508, user-specific hybrid odds based on the received odds. User-specific hybrid odds may be generated by averaging all of the received sets of odds, selecting the lowest risk set of odds, selecting the most accurate set of odds, averaging a subset of the received odds, etc. There may be other ways to determine final odds, such as taking the median of the received odds. For example, if the user-specific hybrid odds generation method is the average of all received odds, and the received odd for the outcome to be an “out” are 1:3 odds and 1:4 odds, then the hybrid odds for the outcome to be an “out” would be 1:3.5 or 2:7. The method of creating user-specific hybrid odds may be adjusting the user-specific hybrid odds, or both may be based on the user's wagering history. For example, a user who rarely places wagers on low odds may cause the bettor odds module to select the highest of the received odds to be the user-specific hybrid odds or may give the highest odds more weight when taking an average of the received odds. The received odds may be modified if the bet is otherwise unfavorable to the user. For example, if user Bob has a history of betting on the Dodgers, the odds of a bet for another team may be adjusted to be more favorable, while the odds of betting on the Dodgers may remain unchanged or even adjusted to be less favorable. In one embodiment, artificial intelligence may also be used to compare the range of odds received to the range of odds generated for similar plays in the past. For example, the gap between the highest and lowest odds returned on a given outcome may be compared to the amount of action wagered on that play or the profit to the house. That comparison may be made through linear regression, cross-correlation, or another mathematical model to identify the most profitable odds or the odds that generated the most action. The bettor odds module 29836 sends, at step 30510, the created user-specific hybrid odds to the base wagering module 29824. If only one set of odds was received, the bettor odds module 29836 sends, at step 30512, the received odds to the base wagering module 29824. The bettor odds module ends at step 30514.

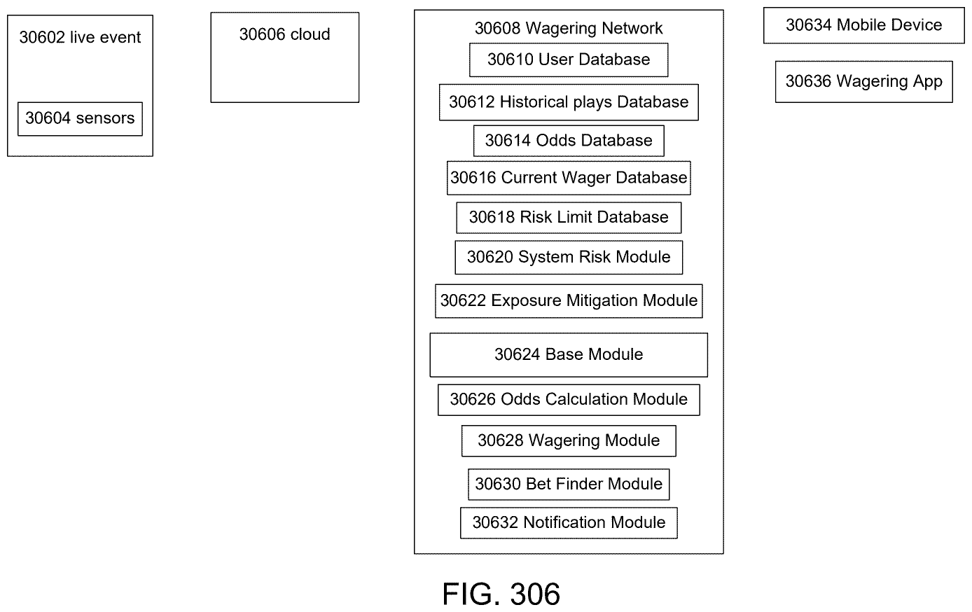

FIG. 306 illustrates a system for a method of displaying a notification from a betting application using AI that can impact normal betting, according to an embodiment.

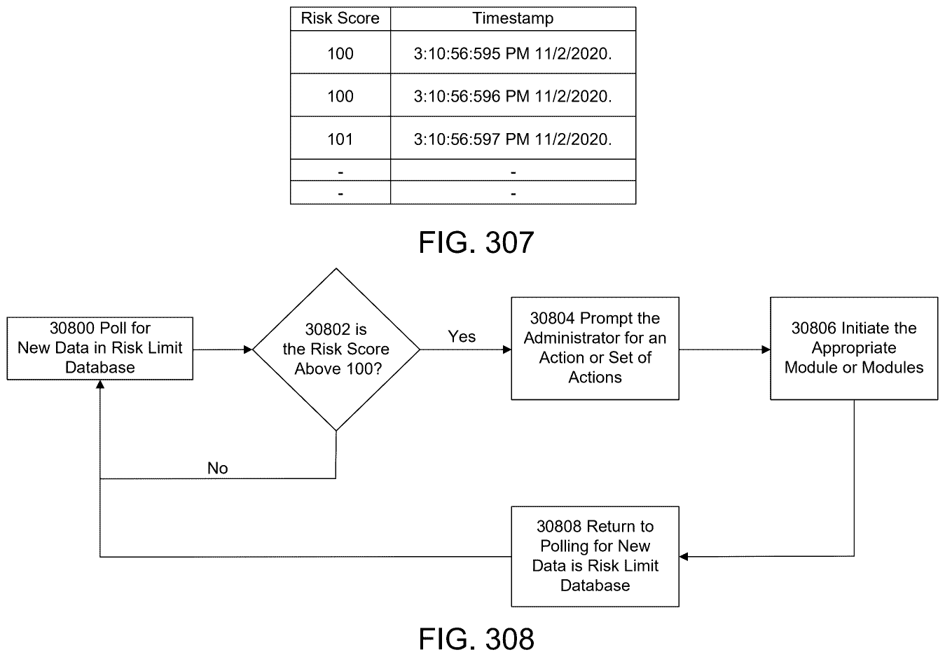

FIG. 307 illustrates a risk limits database, according to an embodiment.

FIG. 308 illustrates a system risk module, according to an embodiment.

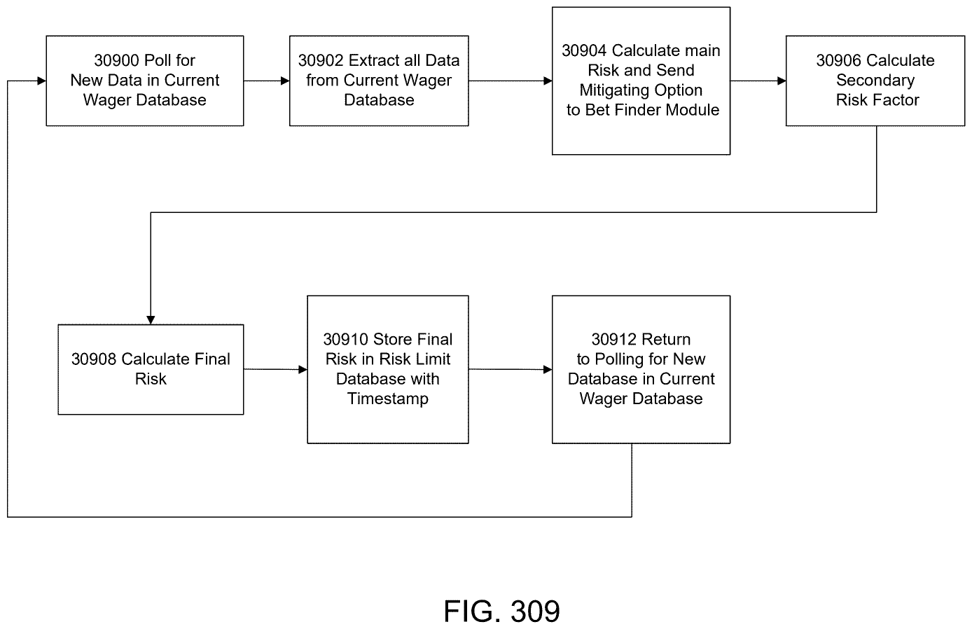

FIG. 309 illustrates an exposure mitigation module, according to an embodiment.

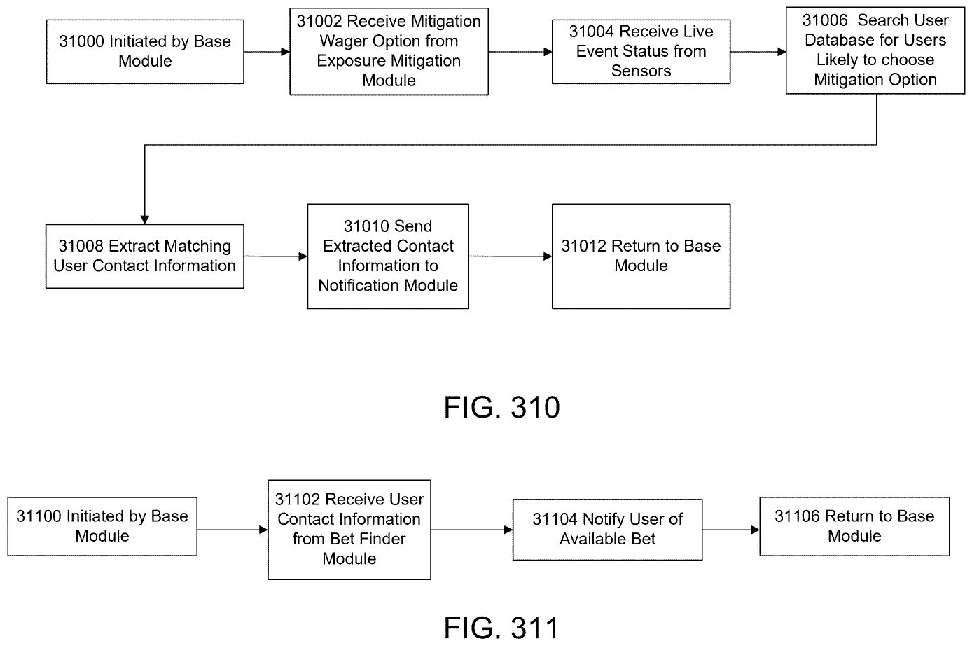

FIG. 310 illustrates a bet finder module, according to an embodiment.

FIG. 311 illustrates a notification module, according to an embodiment.

FIG. 306 is a system for a method of displaying a notification from a betting application using AI that can impact normal betting. This system comprises of a live event 30602, for example a sporting event such as a football game, basketball game, baseball game, hockey game, tennis match, golf tournament, eSports or digital game, etc. The live event will include some number of actions or plays, upon which a user or bettor or customer can place a bet or wager, typically through an entity called a sportsbook. There are numerous types of wagers the bettor can make, including, a straight bet, a money line bet, a bet with a point spread or line that bettor's team would need to cover, if the result of the game was the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including parlays, teasers, and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event, such as the score of American football or the run line in baseball, or a series of action in the live event. Sportsbooks have a number of bets they can handle, a limit of wagers they can take on either side of a bet before they will move the line or odds off of the opening line. Additionally, there are circumstances, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half-time bets. Additionally, the sportsbook can offer futures bets on live events in the future. Sportsbooks need to offer payment processing services in order to cash out customers. This can be done at kiosks at the live event or at another location.

Further, embodiments may include a plurality of sensors 30604 that may be used such as motion sensors, temperature sensors, humidity sensors, cameras such as an RGB-D Camera which is a digital camera capturing color (RGB) and depth information for every pixel in an image, microphones, radiofrequency receiver, a thermal imager, a radar device, a lidar device, an ultrasound device, a speaker, wearable devices etc. Also, the plurality of sensors may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that captures statistical information through real-time X, Y positioning of players and X, Y, Z positioning of the ball.

Further, embodiments may include a cloud 30606 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance. The cloud 30606 may be communicatively coupled to wagering network 30608 which may perform real time analysis on the type of play and the result of the play. The cloud 30606 may also be synchronized with game situational data, such as the time of the game, the score, location on the field, weather conditions, and the like which may affect the choice of play utilized. For example, in other exemplary embodiments, the cloud may not receive data gathered from sensors and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein.

Further, embodiments may include a wagering network 30608 which may perform real time analysis on the type of play and the result of a play or action. The wagering network 30608 (or cloud 30606) may also be synchronized with game situational data, such as the time of the game, the score, location on the field, weather conditions, and the like which may affect the choice of play utilized. For example, in other exemplary embodiments, a wagering network 30608 may not receive data gathered from sensors and may, instead, receive data from an alternative data feed, such as SportsRadar®. This data may be provided substantially immediately following the completion of any play and the data from this feed may be compared with a variety of team data and league data based on a variety of elements, including down, possession, score, time, team, and so forth, as described in various exemplary embodiments herein. The wagering network can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can deliver engaging promotions to the user.

Further, embodiments may utilize a user database 30610 which contains data relevant to all users of the system, which may include, a user ID, a device identifier, a paired device identifier, wagering history, and wallet information for each user.

Further, embodiments may include a historical play database 30612, that contains play data for the type of sport being played in a live event 30602. For example, in American Football, for optimal odds calculation, the historical play data should include meta data about the historical plays, such as time, location, weather, previous plays, opponent, physiological data, etc.

Further, embodiments may utilize an odds database 30614 that contains the odds calculated by the odds calculation module, and the multipliers for distance and path deviation, and is used for reference by the wagering module 30628 and to take bets from the user through a user interface and calculate the payouts to the user.

Further, embodiments may utilize a current wager database 30616 that contains a running tally of all open wagers so the system can calculate its current exposure level on each potential outcome of the coming play.

Further, embodiments may utilize a risk limits database 30618 that stores risks on wagers calculated by the exposure mitigation module 30622.

Further, embodiments may utilize system risk module 30620 that alerts an administrator when the risk exposure of a play is too high. This gives the administrator a real time response to send an alert which might stop and further bets to limit the exposure before all bets are in.

Further, embodiments may utilize an exposure mitigation module 30622 that polls the current wager database for new data events (e.g. a new wager) and then calculates risk exposure on that outcome. The main focus of this module is imbalance of wagers on a play, in other embodiments the exposure mitigation module 30622 may account for other types of risk such as player injury, drastic weather change, or equipment failure.

Further, embodiments may utilize a base module 30624 that initiates the odds calculation module 30626, the wagering module 30628, the bet finder module 30630, and the notification module 30632.

Further, embodiments may include an odds calculation module 30626 which utilizes historical play data to calculate odds for in-play wagers.

Further, embodiments may include a wagering module 30628 which displays bet options to users and allows them to make a wager selection and wager an amount of money or credit.

Further, embodiments may include a bet finder module 30630 which first receives the level of risk calculated by the exposure mitigation module 30622 and based on the level of risk finds users who based on historical data tend to make bets that would offset the risk.

Further, embodiments may include a notification module 30632 which notifies users found by the bet finder module that a wager is available and encourages them to place a wager.

Further, embodiments may include a mobile device 30634 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands. Some devices allow for voice recognition and inputs, including, e.g., Microsoft KINECT, SIRI for IPHONE by Apple, Google Now or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fiber Channel bus, or a Thunderbolt bus. In some embodiments the mobile device 30634 could be an optional component and would be utilized in a situation in which a paired wearable device is utilizing the mobile device 30634 as additional memory or computing power or connection to the internet.

Further, embodiments may include a wagering app 30636, which is a program that enables the user to place bets on individual plays in the live event 30602, and display the audio and video from the live event 30602, along with the available wagers on the mobile device 30634. The wagering app 30636 allows the user to interact with the wagering network 30608 in order to place bets and provide payment/receive funds based on wager outcomes.

FIG. 307 illustrates the risk limits database 30618. The risk limits database 30618 contains risks on wagers calculated by the exposure mitigation module 30622. The risk is stored as a whole number or risk score, for example 100, and each stored risk has a time stamp of when it was calculated, for example, 3:10:56:595 PM Nov. 2, 2020. In some embodiments the accuracy of the timestamp may be dependent on the speed at which the exposure mitigation module 30622 updates. In some embodiments the risk limits database 30618 may contain additional identifiers to differentiate between different plays, games, wager options, etc 0.2

FIG. 308 illustrates the system risk module 30620. The process begins with the system risk module 30620 polling, at step 30800, for new data in the risk limits database 30618. The system risk module 30620 determines, at step 30802, if the risk score of the new data is above 100. In other embodiments the threshold may be different than 100 and may be set by the administrator, a third party, or another module and may be static or dynamic. The system risk module 30620 prompts, at step 30804, the administrator for an action or set of actions to take, for example, the administrator may choose to close the betting window, change the odds, incentivize users to bet on options that would reduce the risk score, or any combination of actions. In an embodiment this selection of actions may be facilitated by a GUI. The system risk module 30620 initiates, at step 30806, the module or modules corresponding to the action or actions selected by the administrator. For example, if the administrator selected to adjust the odds the system risk module may initiate an “odds adjustment module”. In some cases, the system risk module 30620 may not initiate modules directly but may indicate to another module, for example the base module 30624, which modules should be initiated. The system risk module 30620 returns, at step 30808, to polling for new data from the risk limits database. In some embodiments the system risk module may wait for some amount of time before returning to polling for new data from the risk limits database in order to give the actions taken by the administrator time to take effect before checking if there is still a risk score above threshold.

FIG. 309 illustrates the exposure mitigation module 30622. The process begins with the exposure mitigation module 30622 polling, at step 30900, for new data in the current wager database 30616. The exposure mitigation module 30622 extracts, at step 30902, all data from the current wager database 30616. The exposure mitigation module 30622 calculates, at step 30904, a main risk based on the imbalance between selected wager options. Normally odds are calculated in such a way that despite the outcome of the play there is always enough money lost by users to pay off the money won by users. However, in cases where an unexpected number of users select one wager option, the offeror of the wager risks taking a loss. For example, in a simple play where there is only one possible result, two betting options “run” or “pass”, and the odds for each option are 2 to 1, then there is no risk if exactly half of all money is bet on each option, since the losses from the losing half will pay for the winnings of the winning half. However, if one additional dollar is wagered on “run” then “pass” then the bet offeror stands to lose money if the result of the play is a pass. To calculate risk for this example the exposure mitigation module could determine the amount of gain if a run occurs minus the amount of loss if a run occurs, and similarly for if a pass occurred. In this example only a run would result in a loss to the offeror of the bet, so the amount of loss would be multiplied by the likelihood of the outcome occurring to determine the risk, in this example the risk would be $1 multiplied by 50% (note that the internal odds of an outcome and the odds given to bettors may differ because the offeror of the bet usually earns money by slightly reducing the odds), and the risk would be $0.50. This 0.50 is the risk score for the main risk for the wager. In more complex wagers where there may be more than one result that risks a loss, the risk will be the highest risk score among those results, in other embodiments the risk scores may be combined, for example, by taking an average. In some embodiments risk score could be created by a previous defined rule or could be developed by looking at past historical rates and amounts of the particular bets or groups of bets or all bets, using AI, to enhance the exposure risk. The wager options that are do not contribute to the main risk are mitigating options, meaning users betting on these options would reduce the main risk. The exposure mitigation 30622 module sends these options to the bet finer module 30630. The exposure mitigation module 30622 calculates, at step 30906, a secondary risk factor based on known risks which would not have been accounted for in the original odds calculation. The exposure mitigation module 30622 determines from any known data about the play, if there is a (1) past or current injury to a player key to the event in play, (2) drastic weather changes in a sporting event, (3) star player equipment failure, this module searches through the wager history database, using AI, if the any of the secondary risks. For instance, a key player results were considerably reduced for 1-2 days after an injury and this was highly correlated. If this was found, a weighting factor is returned to be used to modify the main risk. The secondary risk factor is calculated from the historical play data based on the amount that the secondary risk contributed to an outcome that would result in a loss based on the main risk. For example, a wrist injury to the quarterback of a football game may often result in an increase in runs over passes. If the offeror of the bet stands to lose money on a run, then the risk factor would reflect the increased amount of plays that will result in runs. If runs are 20% more common when the quarterback of a football game has an injured wrist, then the secondary risk factor would be 1.2. In some embodiments, the secondary risk factor may be retrieved from a database of known risks, for example, if a player is injured, the exposure mitigation module 30622 may look up “player injury” in a database and may find an associated risk factor of 1.2. The exposure mitigation module 30622 calculates, at step 30908, the final risk score by multiplying the main risk by the secondary risk factor. In some embodiments there may be more than one secondary risk factor in which case the final risk may be calculated by multiplying the main risk by all secondary risk factors or by the largest secondary risk factor. The exposure mitigation module 30622 stores, at step 30910, the final risk score in the risk limits database with a timestamp. The exposure mitigation module 30622 returns, at step 30912, to polling for new data in the current wager database 30616.

FIG. 310 illustrates the bet finder module 30630. The process begins with the bet finder module 30630 being, at step 31000, initiated by the base module 30624. The bet finder module 30630 receives, at step 31002, mitigating wager options send by the exposure mitigation module 30622. The bet finder module 30630 receives, at step 31004, data on the status of the live event 30602 from the sensors 30604. For example the bet finder module 30630 may receive data that identifies the live event 30602 as a football game between the Los Angeles Chargers and the Denver Broncos, wherein the Broncos are on offense, it is 3rd and 10 and 3 minutes into the 4th quarter, and the weather is fair. The bet finder module 30630 searches, at step 31006, for users likely to choose the mitigating wager options. The bet finder module 30630 looks for users with a history of betting for the mitigating wager options more often than average and may use filters to narrow down the search closer to the current state of the live game. For example, based on the data from the sensors 30604 the live event 30602 is a football game between the Los Angeles Chargers and the Denver Broncos, wherein the Broncos are on offense, it is 3rd and 10 and 3 minutes into the 4th quarter, and the weather is fair. Two wager options are available to users, “run” or “pass”, and an unexpected number of users have selected “run”. The exposure mitigation module 30622 has determined that there is a risk of loss because of the imbalance between the two wager options and has sent the wager option “pass” to the bet finder module 30630 as a mitigating wager option. The bet finder module 30630 searches the user database for users who often, or at least more often than average, choose the wager option pass when the Broncos are playing against the Chargers, the Broncos are on offense, it is 3rd and 10 and 3 minutes into the 4th quarter, and the weather is fair. In some embodiments not every filter must match the exact state of the live game 30602, for example, wagers made by users when the Broncos are not playing the Chargers or when it is 3rd and 9 instead of 3rd and 10 may be included. In some embodiments the amount and strictness of the filters may be based on the amount of users needed to mitigate risk, for example, if an estimated 1000 users are needed to bet on the mitigating option, the bet finder module 30630 may find 1000 users, starting with those with bets made that most closely match the state of the live game 30602 then reducing the threshold requirements to be considered similar until 1000 users are found. In some embodiments an artificial intelligence algorithm will determine which parameters are correlated with the chosen bet options and filter the search based on only the parameters that significantly affect wager selection. The bet finder module 30630 extracts, at step 31008, the contact information of the matching users. Contact information refers to any method by which the user can be notified of an available wager for example, an email, phone number, or an identifier such as a username by which the user can be sent a notification via the wagering app 30636. The bet finder module 30630 sends, at step 31010, the extracted contact information for each user to the notification module 30632. The bet finder module 30630 returns, at step 31012, to the base module 30624.

FIG. 311 illustrates the notification module 30632. The process begins with the notification module 30632 being, at step 31100, initiated by the base module 30624. The notification module 30632 receives, at step 31102, user contact information from the bet finder module 30630. The notification nodule 30632 notifies, at step 31104, each user of the available wager. For example, user John Smith is identified by the bet finder module 30630 as a user who often bets on “pass” which is a mitigating wager option. The notification module 30632 sends John Smith a message based on his contact information, since his contact information is a phone number the notification module 30632 sends the message via SMS text. The message informs John Smith that there is a wager available with text that reads “A wager is available that we think you would like!”. In some embodiments the notification module may contain a link which opens up the wagering app 30636 if not already open. In some embodiments the notification may contain incentives such as discounts, increased odds, free credit, etc. especially if the user chooses the mitigating wager option. The notification module 30632 returns, at step 31106, to the base module 30624.

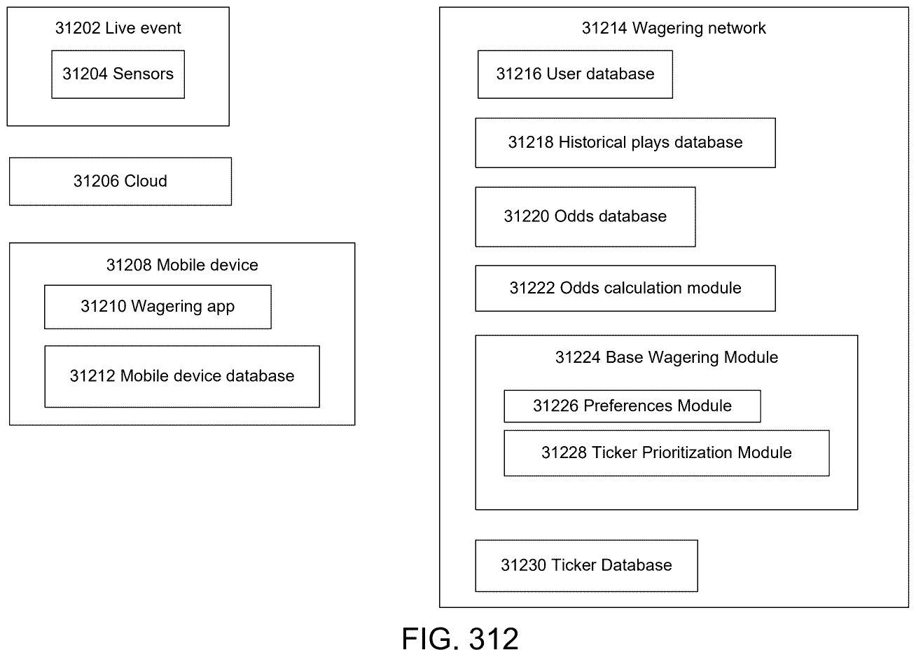

FIG. 312 illustrates a system for a customized rolling ticker feed, according to an embodiment.

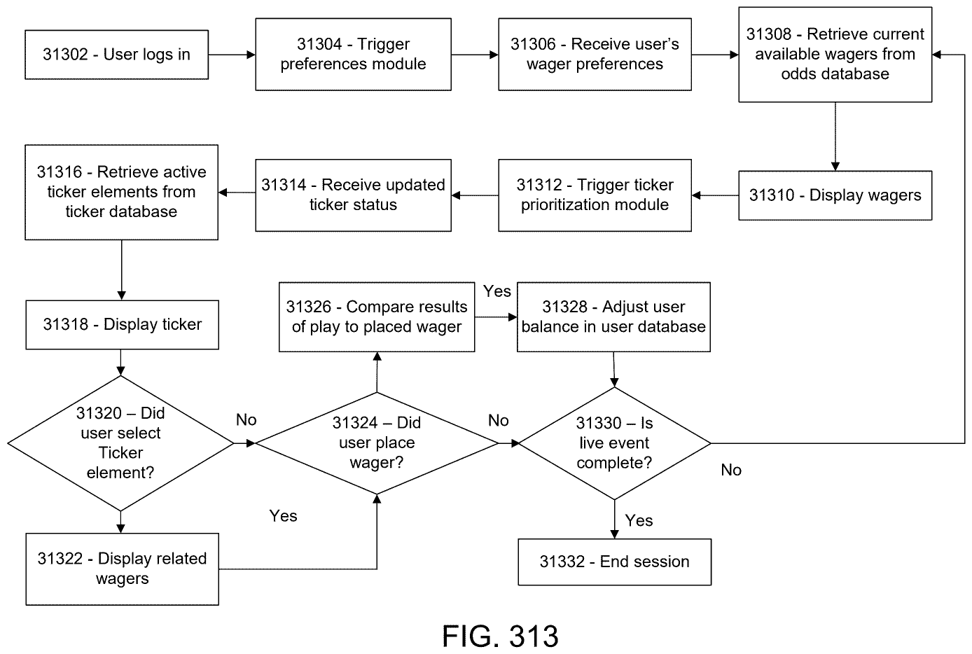

FIG. 313 illustrates a base wagering module, according to an embodiment.

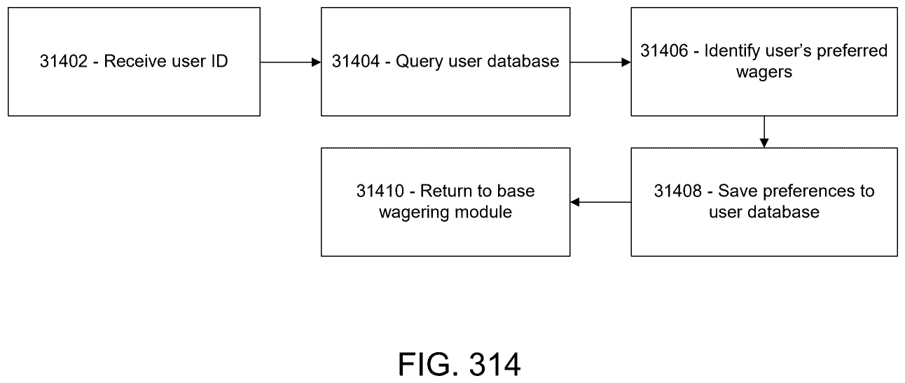

FIG. 314 illustrates a preferences module, according to an embodiment.

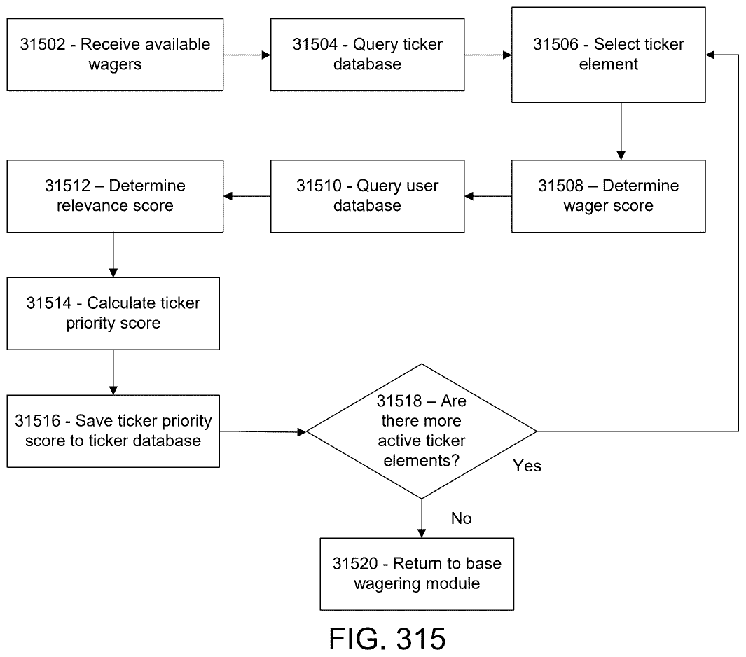

FIG. 315 illustrates a ticker prioritization module, according to an embodiment.

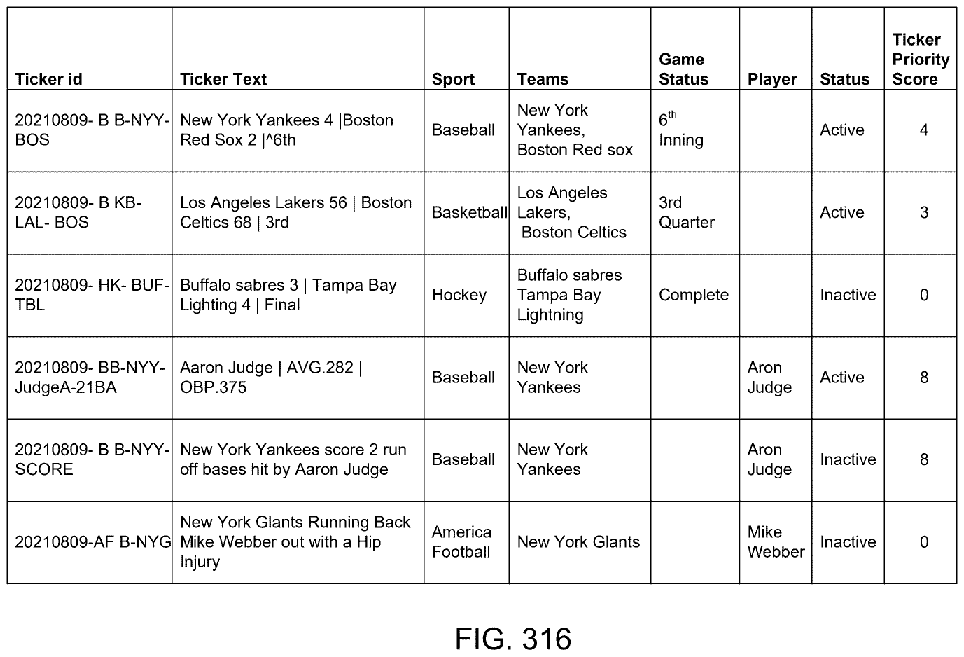

FIG. 316 illustrates a ticker database, according to an embodiment.

FIG. 312 is a system for a customized rolling ticker feed. This system may include a live event 31202, for example, a sporting event such as a football, basketball, baseball, or hockey game, tennis match, golf tournament, eSports, or digital game, etc. The live event 31202 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which may be the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks may allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 31202, such as the score of an American football game or the run line in a baseball game, or a series of actions in the live event 31202. Sportsbooks have several bets they can handle, limiting the number of wagers they can take on either side of a bet before they may move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks may often offer bets on portions of games, such as first-half bets and half-time bets. Additionally, the sportsbook can offer futures bets on live events in the future. Sportsbooks need to offer payment processing services to cash out customers which can be done at kiosks at the live event 31202 or at another location.

Further, embodiments may include a plurality of sensors 31204 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 31204 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 31206 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 31206 may be communicatively coupled to a peer-to-peer wagering network 31214, which may perform real-time analysis on the type of play and the result of the play. The cloud 31206 may also be synchronized with game situational data such as the time of the game, the score, location on the field, weather conditions, and the like, which may affect the choice of play utilized. For example, in an exemplary embodiment, the cloud 31206 may not receive data gathered from the sensors 31204 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 31208 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, Fire Wire, Ethernet, Gigabit Ethernet, Fiber Channel, or Thunderbolt buses. In some embodiments, the mobile device 31208 could be an optional component and may be utilized in a situation where a paired wearable device employs the mobile device 108 for additional memory or computing power or connection to the internet.

Further, embodiments may include a wagering software application or a wagering app 31210, which is a program that enables the user to place bets on individual plays in the live event 31202, streams audio and video from the live event 31202, and features the available wagers from the live event 31202 on the mobile device 31208. The wagering app 31210 allows the user to interact with the wagering network 31214 to place bets and provide payment/receive funds based on wager outcomes.

Further, embodiments may include a mobile device database 31212 that may store some or all the user's data, the live event 31202, or the user's interaction with the wagering network 31214.

Further, embodiments may include the wagering network 31214, which may perform real-time analysis on the type of play and the result of a play or action. The wagering network 31214 (or the cloud 31206) may also be synchronized with game situational data, such as the time of the game, the score, location on the field, weather conditions, and the like, which may affect the choice of play utilized. For example, in an exemplary embodiment, the wagering network 31214 may not receive data gathered from the sensors 31204 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 31214 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 31216, which may contain data relevant to all users of the wagering network 31214 and may include, but is not limited to, a user ID, a device identifier, a paired device identifier, wagering history, or wallet information for the user. The user database 31216 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 31216 may contain betting lines and search queries. The user database 31216 may be searched based on a search criterion received from the user. Each betting line may include but is not limited to, a plurality of betting attributes such as at least one of the following: the live event 31202, a team, a player, an amount of wager, etc. The user database 31216 may include, but is not limited to, information related to all the users involved in the live event 31202. In one exemplary embodiment, the user database 31216 may include information for generating a user authenticity report and a wagering verification report. Further, the user database 31216 may be used to store user statistics like, but not limited to, the retention period for a particular user, frequency of wagers placed by a particular user, the average amount of wager placed by each user, etc.

Further, embodiments may include a historical plays database 31218 that may contain play data for the type of sport being played in the live event 31202. For example, in American Football, for optimal odds calculation, the historical play data may include metadata about the historical plays, such as time, location, weather, previous plays, opponent, physiological data, etc.

Further, embodiments may utilize an odds database 31220—that may contain the odds calculated by an odds calculation module 31222—to display the odds on the user's mobile device 108 and take bets from the user through the mobile device wagering app 31210.

Further, embodiments may include the odds calculation module 31222, which may utilize historical play data to calculate odds for in-play wagers. may comprise

Further, embodiments may include a base wagering module 31224, which may allow users to log in and determine their wager preferences using a preferences module 31226. The base wagering module 31224 may further use the user's wager preferences and the available wagers from the odds database 31220 to prioritize ticker elements to be displayed to a user via a ticker feed on a wagering app 31210. The ticker feed may be displayed to the user with at least one available wager to place on a play during a live event 31202. In addition, the user may interact with the ticker element to view more available wagers related to the ticker element.

Further, embodiments may include a preferences module 31226 that may query a user database 31216 and may receive additional information from a user to determine the user's wager preferences, comprising the types of wagers and odds for which the user is likely to place a wager. Preferences may be based upon the user's past wagers and may additionally use past interactions made with ticker elements. Each of the wagers and the ticker elements may have at least one characteristic such as a type of live event 31202, participants in the live event 31202 such as an athletic team or player, and further may include contextual information such as the type of play wagered upon, the period of gameplay, time of day, geographic location, etc. of the live event 31202, wager or ticker element.

Further, embodiments may include a ticker prioritization module 31228, which may receive currently available wagers from the base wagering module 31224 and may query the ticker database 31230 to retrieve active ticker elements. Active ticker elements may be comprised of news events, statistics, or live event 31202 status updates provided to a user via a ticker feed. Ticker elements may be inactive if they are no longer relevant as determined by the administrator of a wagering network or a third party. A ticker element may also be determined to be inactive if a user dismisses a ticker element. A ticker element may be selected, and the characteristics of the ticker element may be compared with the characteristics of the wagers received from the base wagering module 31224 to determine a wager score. The user database 31216 may be queried to receive the user's wager preferences which may then be compared to the characteristics of the ticker element to determine a relevance score. The wager score and the relevance score may then be used to calculate a ticker priority score indicating the relevance of the ticker element to the user in the context of the currently available wagers. The ticker priority score may then be saved to the ticker database, and the process may be repeated for all remaining active ticker elements.

Further, embodiments may include a ticker database 31230 for storing ticker elements comprised of any game scores, team or player statistics, news events, etc. Game scores may include final game scores, the current score, and the game's status, which may include the period of the game, inning, time remaining, etc. Similarly, a ticker element may be a notification that a team or player has scored or achieved another notable action during the live event 31202, such as an American football player achieving a total rushing yards run record or breaking the record for the longest field goal. Team or player statistics may include all-time statistics, career statistics, current season statistics, or current game or series statistics. Examples of team statistics including a team's win-loss record against their current opponent, a team's current ranking in the current season's standings, a team's average runs scored in a game, etc. Examples of player statistics may include a pitcher's win record, earned run average, number of saves, batter's batting average, on-base percentage, number of runs batted in, number of home runs, etc. In basketball, statistics include a player's field goal percentage, career points, the average number of assists per game. In football, statistics may include passing yards, rushing yards, points scored, etc. A ticker element may also comprise news events such as a player injury, the announcement of a player's trade from their current team to a new team, or a delay in gameplay due to rain. A ticker element may additionally include details about a wager, such as a new wager available to be placed, or changes to a wager such as improved odds or the results of a wager placed by the user. The ticker database 31230 may additionally store a ticker priority score calculated by the ticker prioritization module 31228, which may indicate the relevance of a ticker element to a user's preferences based on their wager history and the currently available wagers. The ticker database 31230 may be populated by the administrator of a wagering network 31214 and may additionally be updated by a third party, such as via a sports news or statistics database or service. The ticker database 31230 may further be updated by the ticker prioritization module 31228 and may be used by the base wagering module 31224 and the ticker prioritization module 31228.

FIG. 313 illustrates the base wagering module 31224. The process may begin with the user logging in, at step 31302, to the wagering app 31210. The user may log in with a username and a password. The username may comprise an email address or a string of alphanumeric characters or symbols chosen by the user or generated randomly. Similarly, the password may comprise alphanumeric characters or symbols chosen by the user or generated randomly. Alternatively, the user may log in using a password manager, which may store the username and password, allowing for a universal password or pin number, or biometrics including fingerprint, facial recognition, or iris scanning to authenticate the user and log into the wagering app 31210. The base wagering module 31224 may trigger, at step 31304, the preferences module 31226 by providing the user's identifying information, such as a user ID or account number, to the preferences module 31226, which may retrieve the user's historical wagering data from the user database 31216 and may receive additional data provided by the user to identify the user's wager preferences. Additionally, retrieving the user's ticker element interactions may be used to determine the user's wagering preferences. In an embodiment, the user ID for a user, John Smith, is 3596344. The base wagering module 31224 may receive, at step 31306, the user's wager preferences from the preferences module 31228. The wager preferences for the user John Smith comprising baseball games, especially those where the New York Yankees are competing and wagers involving batters, such as whether a batter may strike out or get a base hit or hit a home run, earn an RBI, etc. The base wagering module 31224 may retrieve, at step 31308, the currently available wagers on the live event 31202 from the odds database 31220. The odds may be calculated by the odds calculation module 31222 and comprising a win condition and odds, which may be represented as a payout ratio, such as 5:1 where a person wagering $10 would receive $50 for a successful outcome. In an embodiment, an exemplary wager during a baseball game between the New York Yankees and the Boston Red Sox is that the next batter may get a base hit at odds of 3:1. The wager may additionally include a default wager amount such as $50. The currently available wagers may comprise all currently available wagers or a selection of all currently available wagers. The wagers may be selected randomly or according to the user's preferences as determined by the preferences module 31226 and stored in the user database 31216. The wagers may similarly be based upon the user's wagering history, including trends in the user's recent wagers, such as the wagers placed during the current session or live event 31202. In an embodiment, a selected wager is that the next batter during a baseball game between the New York Yankees and the Boston Red Sox may get a base hit at odds of 3:1. Additionally, a selected wager may include that the New York Yankees may score at least two runs in the current inning. Selected wagers may additionally be related to different live events 31202, such as basketball games, American football games, hockey games, etc. The base wagering module 31224 may display, at step 31310, the available wagers to the user via a wagering app 31210. The user may be presented a single wager or multiple wagers, which may be presented individually, or multiple wagers may be displayed on the screen simultaneously. The user may scroll or page through the wagers. In an embodiment, the wagers may be displayed in a list on a wagering app 31210 on a mobile device. The base wagering module 31224 may trigger, at step 31212, the ticker prioritization module 31228 and send the currently available wagers as retrieved from the odds database 31220. Additionally, the base wagering module 31224 may send the wager visibility status, indicating whether being viewed by the user. A wager may be visible if it is actively displayed on the mobile device 31208 or in a list of wagers displayed to the user. The ticker prioritization module 31228 may additionally query the ticker database 31230 for active ticker elements and the user database 31216 for the user's wager preferences, including the user's previous interactions with ticker elements. An active ticker element may be selected, and scores are calculated for relevance to the user's preferences and the available wagers. The scores may then be used to calculate a ticker priority score which may be saved to the ticker database 31230, and the process may be repeated for all active ticker elements. An available wager that the next batter during a baseball game between the New York Yankees and the Boston Red Sox may get a base hit at odds of 3:1. An additional wager may be available on the New York Yankees, scoring at least two runs in the current inning at odds of 12:1. The base wagering module 31224 may receive an updated ticker status, at step 31314, from the ticker prioritization module 31228. The ticker status may indicate that the active ticker elements have been updated with a ticker priority score, indicating the relevance of each ticker element to the user based on the user's preferences and wager history. The ticker priority score additionally may reflect relevance to the wagers available to be placed by the user. Active ticker elements may be retrieved by the base wagering module 31224, at step 31316, from the ticker database 31230. The active ticker elements may comprise statistics or news related to at least one live event 31202 and include a ticker priority score calculated by the ticker prioritization module 31228. Examples of ticker elements may include the score of a sporting event, including a baseball game, basketball game, American football game, hockey game, etc. Ticker elements may further relate to performance statistics, injury status, etc., of participants in the live event 31202, such as an athletic team or players. In an embodiment, a ticker element comprising the 2021 season batting average for New York Yankees player, Aaron Judge, which may be 0.282 and his on-base percentage is 0.375, which may have a ticker priority score of 11. Another ticker element comprising the score of a baseball game between the New York Yankees and the Boston Red Sox with the Boston Red Sox leading with a score of 5 to 3 in the bottom of the 6th inning with a ticker priority score of 9. The base wagering module 31224 may display, at step 31318, the ticker elements in a ticker feed on a wagering app 31210 such that the ticker is visible to the user while the user is viewing the one or more available wagers. The ticker elements may be displayed such that the ticker element with the highest ticker priority score may be displayed first, and additional ticker elements may be displayed in the descending score order, with the last ticker element displayed having the lowest priority score. All the active ticker elements may be displayed, or a maximum number of ticker elements may be predetermined, such as no more than ten ticker elements. Alternatively, only ticker elements above a threshold priority score may be displayed, such as ticker elements with a score above 5. In some embodiments, both a priority score threshold and a maximum number of ticker elements may be defined to limit the number of ticker elements displayed. When all active ticker elements may be displayed to the user, the ticker elements may repeat, such that after the last ticker element is displayed, the first ticker element may be displayed again. The ticker elements may additionally be selectable by the user, such as by double-tapping the screen of the mobile device 31208 on the ticker element or via a long press. In an embodiment, first displaying a ticker element comprising the 2021 season batting average for New York Yankees player, Aaron Judge, may be 0.282. His on-base percentage may be 0.375, which may have a ticker priority score of 11 and then display the ticker element comprising the score of a baseball game between the New York Yankees and the Boston Red Sox, with the Boston Red Sox leading with a score of 5 to 3 in the bottom of the 6th inning with a ticker priority score of 9. The base wagering module 31224 may determine, at step 31320, whether the user selected the displayed ticker element. The user may select the ticker element by double-tapping the screen of the mobile device 31208 on the ticker element or via a long press. Alternatively, the user may use tactile inputs or provide a voice prompt to the mobile device 108 instructing the wagering app 31210 to display currently available wagers related to the ticker element. In an embodiment, the currently displayed ticker element may be the 2021 batting average and on-base percentage for New York Yankees player, Aaron Judge and the user, John Smith, selects the ticker element by double-tapping the ticker element on the mobile device 31208. Wagers related to the selected ticker element may be displayed at step 31322. The wagers may include at least one wager characteristic common to the selected ticker element. The displayed wagers may additionally be selected based upon the user's preferences as stored in the user database 31216 and determined by the preferences module 31226. In response to selecting the ticker element showing the 2021 batting average and on-base percentage for New York Yankees player, Aaron Judge, displaying related wagers including a wager that Aaron Judge may get a base hit on his next at-bat with odds of 3:1 as both the wager and the ticker element share the characteristics of the New York Yankees and the player, Aaron Judge. An additional wager may include a wager that the New York Yankees may win their in-progress game with the Boston Red Sox with odds of 2:1 because both the wager and the ticker element share the characteristic of New York Yankees. A wager from the user may be received at step 31324. The wager comprising a wager amount that the win condition may occur at the specified odds such that the odds represent the multiple to be applied to the wager amount to determine the payout provided the user wins the wager. In an embodiment, the user John Smith may place a wager for $50 that the next batter may get a base hit at odds of 3:1. Alternatively, the user may not place a wager by either selecting an option to pass on placing a wager or allowing the opportunity period during which the user can place a wager to elapse. In an embodiment, the user John Smith may allow the opportunity period to elapse without placing a wager. The base wagering module 31224 may compare the play results during the live event 31202, at step 31326, to the win condition of the selected wager to determine whether the user won the wager. In an embodiment, the next batter struck out and did not get a base hit; therefore, the user John Smith did not win the wager. In an alternate embodiment, the next batter hit a double and therefore got a base hit, in which case the user John Smith won the wager. The user's account balance may be adjusted by the base wagering module 31224, at step 31328, according to the wager results. If the user lost the wager, the wager amount may be deducted from the user's account. Alternatively, if the user won the wager, the payout amount may be determined by multiplying the wager amount by the odds. The payout amount may then be added to the user's account balance. In an embodiment, the user John Smith lost the wager, and therefore the wager amount of $50 may be deducted from his initial account balance of $1200, resulting in a new account balance of $1150. In an alternate embodiment, the user John Smith won the wager, and a payout of $150, determined by multiplying the wager amount of $50 by the odds of 3:1, may be added to the initial account balance of $1200, resulting in a new account balance of $1350. The base wagering module 31224 may determine, at step 31330, whether the live event 31202 is complete. The live event 31202 may be complete if it has concluded, such as the end of elapsed playtime during a sporting event. In an embodiment, a baseball game may be concluded after the third out of the top of the 9th inning if the home team is leading, after the third out of the top of the 9th inning if the away team is leading, or if the home team scores a winning run in the bottom of the 9th inning. A baseball game may additionally conclude in an inning beyond the 9th inning if the 9th inning concludes in a tie. If the live event 31202 is not complete, the base wagering module 31224 may return to step 31308 and retrieving currently available wagers from the odds database 31220. The base wagering module 31224 may end, at step 31332, the session if the live event 31202 is complete.

FIG. 314 illustrates the preferences module 31226. The process may begin with receiving, at step 31402, a user ID from the base wagering module 31224. The user ID may be associated with a user and their user account. In an embodiment, the user ID is 3596344 and is associated with a user, John Smith. The preferences module 31226 may query, at step 31404, the user database 31216 for details associated with the user such as the user's previous wagers and wager preferences such as the types of live events 31202, athletic teams, players, types of wagers, or odds on which the user prefers to place wagers. The wager information may additionally include geolocation data, such as locations where the user has previously placed wagers or the location of live events 31202 and the proximity of the live event 31202 wagered upon to the user. The user database 31216 may additionally store contextual information about the user's wagers, such as wagers that were also placed by the users' friends and wagers placed as part of a parlay or as a hedge against another wager. The contextual information may also include whether a wager resulted from a challenge by a friend or a wagering app 31210. The user database 31216 additionally including the wager amount and results of the wagers. In an embodiment, a previous wager placed by the user John Smith may include a wager of $100, that Aaron Judge would hit a home run in an at-bat at odds of 10:1. The wager may further include the results that Aaron Judge hit a home run in the designated at-bat, resulting in a $1000 payout. Additional information may include a history of the user's interactions with ticker elements, such as a score update for a baseball game between the New York Yankees and the Boston Red Sox. The preferences module 31226 may identify, at step 31406, the user's preferred wagers based on the user's wager history retrieved from the user database 31216. The preferred wagers may include a type of wager that may be distinguished by characteristics, including any type of live event 31202, athletic team, player, type of wager, or odds involved in the wager. The user may additionally wager upon them at a significantly higher rate than other wagers, such as more than double the average wager. Alternatively, the preferred wagers may be determined by ranking the types of wagers by the total number of wagers placed by the user and selecting a predetermined number of the results, such as the top 5 wagers. In an embodiment, the user John Smith may be determined to prefer to place wagers on batters, such as whether they may get a base hit, strikeout, earn an RBI, etc., during an at-bat. The user's preferred wagers may additionally include contextual bets, such as parlaying or hedging a second bet with a first bet or placing a wager in response to a friend placing a wager or receiving a challenge from a friend to place a particular wager. Such contextual wagers may be determined to be a preferred type of wager if they represent a significant portion of the user's overall wagering activity or if the user meets or exceeds a predetermined threshold value representing the percentage of wagers placed to the number of total opportunities within a particular context. For example, if the user John Smith places a wager 60% of the time in response to the user John Smith's friend, Jane Doe, placing the same wager before John Smith, it may be determined that placing a wager in response to a friend's wager, especially his friend, Jane Doe, is a preferred wager type for user John Smith as it exceeds a predetermined threshold value of 50%. Additionally, the user may manually provide preferences via a wagering app 31210. The user's preferred wagers may also consider the user's interactions with ticker elements such that wagers with characteristics matching the ticker elements with which the user frequently interacts are more preferred than characteristics common to ticker elements and wagers user infrequently or does not interact with. The preferences module 31226 may save, at step 31408, the user's wager preferences to the user database 31216. The user's wager preferences may comprise the types of wagers and wager characteristics the user most frequently chooses to place wagers upon or and the types of wagers the user has chosen as their preferred types of wagers via manually defined preference settings. In an embodiment, updating the user database 31216 with the user John Smith's preferred wagers on the outcome of a baseball player at bat, such as whether the player may get a base hit, strikeout, earn an RBI, etc. Additionally, the preferences module 31226 may save the user John Smith's interactions with ticker elements relating to baseball games in which the New York Yankees are competing. The preferences module 31226 may return, at step 31410, to the base wagering module 31224 with the user's wager preferences. In an embodiment, the wager preferences for a user John Smith including baseball games, particularly those in which the New York Yankees are competing, and additionally plays involving the outcome of a baseball player's at-bat, such as whether the player may get a base hit, strikeout, earn an RBI, etc.

FIG. 315 illustrates the ticker prioritization module 31228. The process may begin with the ticker prioritization module 31228 receiving, at step 31502, the currently available wagers from the base wagering module 31224. In an embodiment, a selected wager may be that the next batter during a baseball game between the New York Yankees and the Boston Red Sox may get a base hit at odds of 3:1. The ticker database 31230 may be queried, at step 31504, by the ticker prioritization module 31228 for active ticker elements. Active ticker elements may include information such as news and statistics related to the live event 31202 or the participants of the live event 31202, which may be displayed to a user via a ticker feed. A ticker feed may typically presented to a user in the form of a band that scrolls across the top or bottom of a display and presents ticker elements to the user in sequential order. Examples of ticker elements may include the score of a baseball game between the New York Yankees and the Boston Red Sox or a basketball game between the Los Angeles Lakers and the Boston Celtics. A game's score may additionally include an indication of the status of the game, such as the inning, and whether it may be the top or bottom of the inning in the case of a basketball game, or the period of the game, which may be the case for events including basketball, American football, and hockey games. For live events 31202, where individual athletes compete against each other such as golf, a ticker element may comprise a list of the top five competitors and their current scores. If the live event 31202 has concluded, a score for that event may include an indication that the game is over, including the word “Final” next to the score or by changing the color of the ticker element when it may be displayed or by highlighting the winner. Ticker elements may alternatively comprise statistics, such as a team's all-time or current season win percentage, or a player's statistics, such as batting average and on-base percentage for a baseball player or total yards run for a football player. The statistics may be for the current live event 31202, the current season, or a player's career. Similarly, the statistics may include comparing a team or player's current performance in the live event 31202 versus their historical performance. The ticker elements may alternatively include news events which may be comprised of an announcement that a player is being traded from one team to another, that a player has been injured, or that a team during an American football team just scored a touchdown. A ticker element may be active if the information is current and is intended for display to a viewer. The ticker element may be created and updated by a third party and saved to the ticker database 31230, determining whether a ticker element is active or inactive. In an embodiment, an active ticker element may be comprised of the 2021 season batting average for New York Yankees player Aaron Judge, which is 0.282, and his on-base percentage is 0.375. A ticker element may be updated to be inactive if the information in the ticker element is no longer accurate or if the administrator of a wagering network 31214 or a third-party database which may be used to update the ticker database 31230 determines the ticker element is no longer relevant or if it was given an expiration time. For example, a ticker element announcing that the New York Yankees scored a run may be given an expiration time of 2 minutes after the run was scored. The ticker prioritization module 31228 may select, at step 31506, a ticker element from the active ticker elements retrieved from the ticker database 31230. In an embodiment, a ticker element comprising the 2021 season batting average for New York Yankees player, Aaron Judge, is 0.282 and his on-base percentage is 0.375. The ticker prioritization module 31228 may determine, at step 31508, a wager score for the selected ticker element by comparing the ticker element to the available wagers. Each available wager being comprised of characteristics that may be used to describe the wager, such as the type of live event 31202, the parties involved, which may include a team and one or more players, and the type of wager such as whether the wager relates to a batter or a pitcher during a baseball game, or whether it relates to a field goal attempt during an American football game. Ticker elements may similarly be comprised of characteristics that can be used to describe them. For example, a ticker element may be comprised of the score of a baseball game between the New York Yankees and the Boston Red Sox, in which case the characteristics may include the type of live event 31202, a baseball game, and the athletic teams, the New York Yankees and the Boston Red Sox. The ticker element may also comprise contextual elements such as the score, which may correlate to a wager characteristic of the topic or type of wager, including wagering upon the result of the live event 31202. The wager score may be determined by comparing wager characteristics and the ticker element characteristics and assigning a score when the characteristics match. The score may be determined by totaling the number of matching wager characteristics and ticker element characteristics. The score may be tallied by considering each unique matching characteristic or all matching characteristics. For example, if the ticker element may be the 2021 season batting average and on-base percentage for New York Yankees player Aaron Judge, then the ticker element characteristics may be the type of live event 31202, baseball, the team, the New York Yankees, the player, Aaron Judge, and the activity of batting. If matching characteristics for all wagers, then if there are five wagers relating to the New York Yankees, this ticker element may be assigned five points for the five matching wager characteristics. Two additional points may be assigned to increase the total to seven if two of those wagers also relate to Aaron Judge. Alternatively, a point may only be assigned for each unique wager, in which case the score may remain five as Aaron Judge is a player on the New York Yankees. In further embodiments, all characteristics may be considered, but they may be weighted. For example, the team characteristic may be weighted at 0.5 points, whereas the player is weighted at 1. For the previous example, the ticker element would have a score of 4.5, with 2.5 points coming from the five wagers involving the New York Yankees and 2 points from the wagers involving Aaron Judge. The ticker element may also be determined by tallying a score for each wager relative to the ticker element individually and then finding an average score for all available wagers to be used as the wager score. Further embodiments may modify the wager score based on whether the user is currently viewing a wager relating to the user's ticker element. The user database 31216 may be queried, at step 31510, by the ticker prioritization module 31228 for the user's wagering preferences. The wagering preferences may comprise the types of live events 31202, the participants of the live events 31202, and the types of plays or actions during the live events 31202 that the user typically wagers upon. In an embodiment, the user John Smith may prefer to place wagers on baseball games, particularly those involving the New York Yankees. The user John Smith additionally preferring to place wagers on plays involving an action or result achieved by a batter. The ticker prioritization module 31228 may determine, at step 31512, a relevance score for the selected ticker element representing how closely the ticker element aligns with the user's preferences by comparing the ticker element to the user preferences identified by the preferences module 31226. The relevance score may be determined similarly to determining the wager score in step 31508. The ticker element may be comprised of characteristics that describe the ticker element, including the type of live event 31202, participants of the live event 31202 including teams and individual players, and additional contextual information such as the score of the live event 31202, statistics relating to a play type such as pitching or batting in a baseball game or yards run in an American football game. These ticker element characteristics may be matched to user preferences, and a score is determined by tallying all preferences matching the ticker element. For example, ticker element may be the 2021 season batting average and on-base percentage for New York Yankees player Aaron Judge; then the ticker element characteristics may be the type of live event 102, baseball, the team, the New York Yankees, the player, Aaron Judge, and the activity of batting. As the wager preferences for the user, John Smith, include baseball games and the New York Yankees, this ticker element's score may be two. If the user preferences also included the player, Aaron Judge, then the relevance score would increase to three. Alternatively, the score may increase if the user's preferences included wagers placed on batters during a baseball game. Similar to the wager score, the relevance score may include weighted scores for each user preference or ticker element characteristic. The ticker priority score for the selected ticker element may be calculated, at step 31514, by the ticker prioritization module 31228 using both the wager and relevance scores. The ticker priority score may be calculated by summing the wager score and the relevance score. Alternatively, the ticker priority score may be calculated by multiplying the wager score and the relevance score. Further embodiments may find the ticker priority score by weighting one or both the wager and relevance scores before summing or otherwise combining the wager and relevance scores. In an example, the relevance score may be multiplied by the total number of available wagers before summing the wager score and the weighted relevance score to even the strength of a wager score to account for an increased score ceiling for the wager score resulting from many available wagers contrasted with the relevance score which is limited to the number of user preferences matching the ticker element characteristics. The ticker priority score may also be calculated using the component scores, such as for each wager characteristic or user preference matching the ticker element the wager score and the relevance score and artificial intelligence, which may be trained by a third party or an administrator of a wagering network 31214 to assign a ticker priority score which maximizes the relevance of ticker elements for a user. The ticker priority score may be stored, at step 31516, by the ticker prioritization module 31528 to the ticker database 31530. The ticker priority score may be associated with its corresponding ticker element and represents the relative priority for displaying the ticker element to the user. A ticker element with a higher ticker priority score should be displayed to a user before a ticker element with a lower ticker priority score. The ticker prioritization module 31228 may determine, at step 31518, whether there are more active ticker elements that have not been assigned a ticker priority score. If there are more active ticker elements, the ticker prioritization module 31228 may return to step 31506 and selecting another ticker element. In an embodiment, there is another ticker element without a ticker priority score comprising the score of a basketball game between the Los Angeles Lakers and the Boston Celtics, with the Lakers leading the Celtics 64 to 58 in the third quarter. In an alternate embodiment, all active ticker elements have been assigned a ticker priority score. The ticker prioritization module 31228 may return, at step 31520, to the base wagering module 31224 with the status that all active ticker elements have been updated with a ticker priority score.

FIG. 316 illustrates the ticker database 31230. The ticker database 31230 may contain ticker elements which may comprise any of game scores, team or player statistics, new events, etc. which may be displayed to the user of a wagering app 31210. Game scores may include the current score of the game and the game status, such as whether the game is completed, and if not, the period in which the game is. For example, a ticker element may be comprised of the score of a baseball game between the New York Yankees with 4 runs and the Boston Red Sox with 2 runs in the top of the sixth inning. Another example may be the score final score of a hockey game between the Buffalo Sabers with a score of three and the Tampa Bay Lightning with a score of 4. A ticker element may comprise a notification that a team or a specific player has scored or achieved another notable action during a live event 31202 such as an American football quarterback breaking an all-time passing yards record or a kicker breaking the record for the longest field goal. Similarly, a ticker element may provide a notification of a score change, such as New York Yankees player scoring 2 runs off a base hit by Aaron Judge. Ticker elements may further be comprised of a team or player statistics which may be all-time statistics, career statistics, current season statistics or current game or series statistics. Examples of team statistics may include a team's win-loss record against their current opponent, a team's current ranking in the current season's standings, a team's average runs scored in a game, etc. Examples of player statistics for a baseball player may include a pitcher's win record, earned run average, number of saves, or a batter's batting average. For a basketball player, those statistics may instead comprise a player's field goal percentage, three-point percentage or average points, rebounds, assists, blocks or steals per game. In football, player statistics may include a quarterback's passing or running yards, points scored, etc. Ticker elements may additionally comprise news events such as the announcement of a player trade, delay in gameplay due to weather, such as rain, or a player injury. For example, a ticker element may comprise the New York Giant's running back, Mike Webber, is out with a hip injury. Similarly, news events may provide updates on a previous news event such as the date a player is expected to return from their current injury. Ticker elements may additionally include details about a wager, such as notifying the user that a new wager is available to be placed or providing the results of a user's current wager. Similarly, a ticker element may inform the user of the status of a parlay or an opportunity to place a parlay. A ticker element may also inform a user of changes to an available wager, such as improved odds for a team or player the user typically places wagers on. The ticker database 31230 may additionally store a ticker priority score calculated by the ticker prioritization module 31228 which may indicate the relevance of a ticker element to a user's preferences based on their wager history and the currently available wagers. The ticker database 31230 may be populated by the administrator of a wagering network 31214 or a third party, such as a sports news or statistics database or service. The ticker database 31230 may be used by the base wagering module 31224 and the ticker prioritization module 31228.

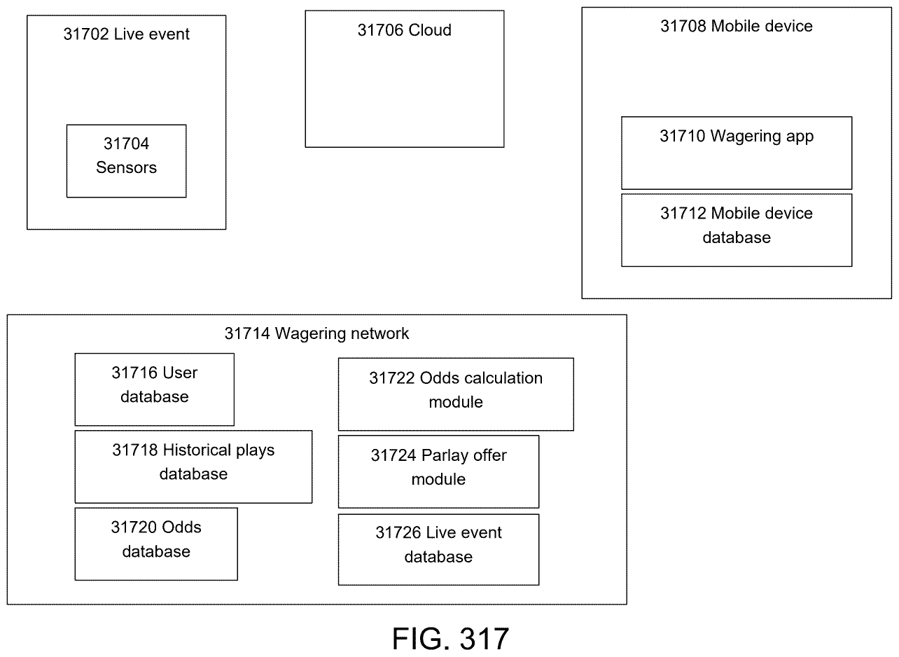

FIG. 317 Illustrates a system for offering a subsequent event parlay wagering, according to an embodiment.

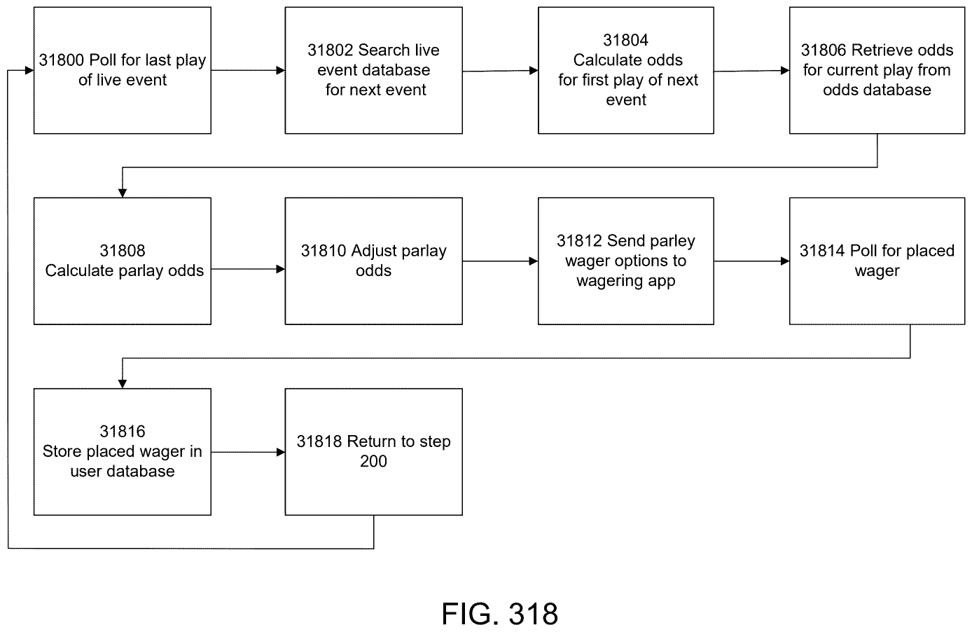

FIG. 318 Illustrates a parlay offer module, according to an embodiment.

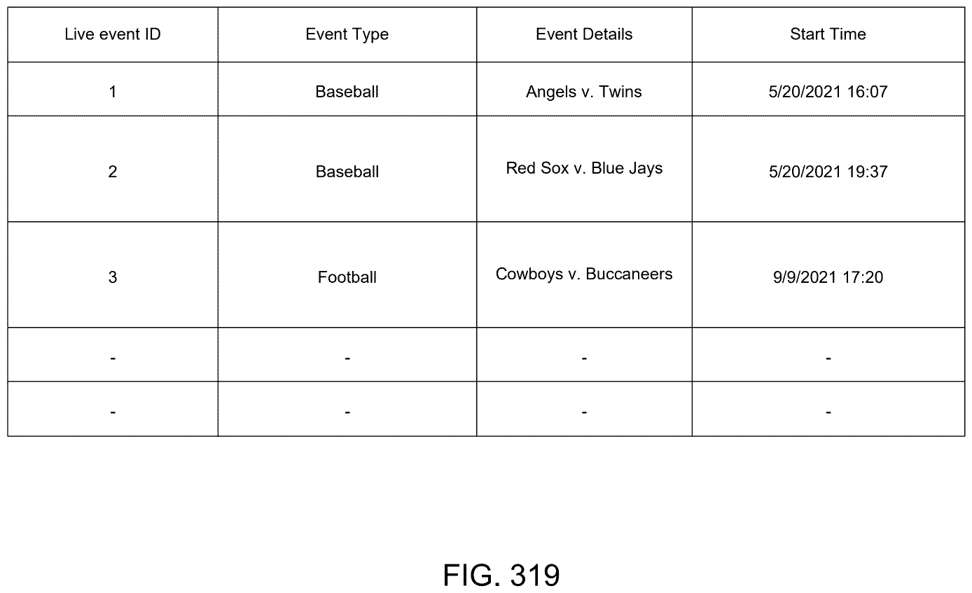

FIG. 319 Illustrates a live event database, according to an embodiment.

FIG. 317 is a system for offering a subsequent event parlay wagering. This system may include a live event 31702, for example, a sporting event such as a football, basketball, baseball, or hockey game, tennis match, golf tournament, eSports or digital game, etc. The live event 31702 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 31702, such as the score of an American football game or the run line in a baseball game, or a series of actions in the live event 31702. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 31702 or at another location.

Further, embodiments may include a plurality of sensors 31704 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 31704 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 31706 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 31706 may be communicatively coupled to a peer-to-peer wagering network 31714, which may perform real-time analysis on the type of play and the result of the play. The cloud 31706 may also be synchronized with game situational data such as the time of the game, the score, location on the field, weather conditions, and the like, which may affect the choice of play utilized. For example, in an exemplary embodiment, the cloud 31706 may not receive data gathered from the sensors 31704 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 31708 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 31708 could be an optional component and would be utilized in a situation where a paired wearable device employs the mobile device 31708 for additional memory or computing power or connection to the internet.

Further, embodiments may include a wagering software application or a wagering app 31710, which is a program that enables the user to place bets on individual plays in the live event 31702, streams audio and video from the live event 31702, and features the available wagers from the live event 31702 on the mobile device 31708. The wagering app 31710 allows the user to interact with the wagering network 31714 to place bets and provide payment/receive funds based on wager outcomes.

Further, embodiments may include a mobile device database 31712 that may store some or all the user's data, the live event 31702, or the user's interaction with the wagering network 31714.

Further, embodiments may include the wagering network 31714, which may perform real-time analysis on the type of play and the result of a play or action. The wagering network 31714 (or the cloud 31706) may also be synchronized with game situational data, such as the time of the game, the score, location on the field, weather conditions, and the like, which may affect the choice of play utilized. For example, in an exemplary embodiment, the wagering network 31714 may not receive data gathered from the sensors 31704 and may, instead, receive data from an alternative data feed, such as SportsRadar®. This data may be provided substantially immediately following the completion of any play, and may be compared with a variety of team data and league data based on a variety of elements, including the current down, possession, score, time, team, and so forth, as described in various exemplary embodiments herein. The wagering network 31714 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 31716, which may contain data relevant to all users of the wagering network 31714 and may include, but is not limited to, a user ID, a device identifier, a paired device identifier, wagering history, or wallet information for the user. The user database 31716 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 31716 may contain betting lines and search queries. The user database 31716 may be searched based on a search criterion received from the user. Each betting line may include, but is not limited to, a plurality of betting attributes such as at least one of the live event 31702, a team, a player, an amount of wager, etc. The user database 31716 may include, but is not limited to, information related to all the users involved in the live event 31702. In one exemplary embodiment, the user database 31716 may include information for generating a user authenticity report and a wagering verification report. Further, the user database 31716 may be used to store user statistics like, but not limited to, the retention period for a particular user, frequency of wagers placed by a particular user, the average amount of wager placed by each user, etc.

Further, embodiments may include a historical plays database 31718 that may contain play data for the type of sport being played in the live event 31702. For example, in American Football, for optimal odds calculation, the historical play data may include metadata about the historical plays, such as time, location, weather, previous plays, opponent, physiological data, etc.

Further, embodiments may utilize an odds database 31720—that contains the odds calculated by an odds calculation module 31722—to display the odds on the user's mobile device 31708 and take bets from the user through the mobile device wagering app 31710.

Further, embodiments may include the odds calculation module 31722, which utilizes historical play data to calculate odds for in-play wagers.

Further, embodiments may include a parlay offer module 31724, which may offer users the option to parlay a bet from the current live event 31702 and a bet from another live event 31702. This parlay offer may be made before or after the user has placed a wager.

Further, embodiments may include a live event database 31726, containing data on live events 31702.

FIG. 318 illustrates the parlay offer module 31724. The process may begin with the parlay offer module 31724 polling, at step 31800, for a play, which may be a final or last play of the live event 31702, or may be any other play of the live event 31702. Depending on the type of live event 31702, it may be impossible to determine which play is the final play of the live event 31702, so another play that occurs during the live event may be utilized, as desired. The parlay offer module 31724 may poll for a play that could be the final play of the live event 31702. For example, in baseball, the end of the final inning is determined by the number of outs and the difference in the score and not a timed clock. However, it may be envisioned that the play could be a play at the end of an inning, at the end of a quarter (for example in football), or any other play. The parlay offer module 31724 may search, at step 31802, the live event database 31726 for the next live event 31702. The parlay offer module 31724 may give preference to live events 31702 that are of the same type as the current live event 31702. The parlay offer module 31724 may calculate, at step 31804, odds for the first play of the next live event 31702. The first play of the next live event, 31702, maybe an easily predictable play, such as a coin toss. Alternatively, the initial state of the next live event 31702 may be predicted and the odds determined based on that prediction. For example, if the next game is a baseball game, then the first batter and first pitcher may be known, and odds may be determined based on historical data on those players. The parlay offer module 31724 may retrieve, at step 31806, odds for the current play of the live event 31702 from the odds database 31720. The parlay offer module 31724 may calculate, at step 31808, parlay odds for the combination of wagers. This calculation may be multiplying the individual odds together. For example, the current live event 31702 and the next live event 31702 are American football games. The odds that the final play of the current live event 31702 is a touchdown is 20%. The odds that the coin flip of the next live event 31702 is heads is 50%. Then, the odds of both of those outcomes occurring independently is 50% times 20%, which is 10%. The parlay offer module 31724 may adjust, at step 31810, the parlay wager odds. The odds may be adjusted to account for profit or to hedge against loss. The odds may be adjusted to encourage users to take the parlay wager. Odds may be adjusted for each user based on the past betting behavior of that user. In another example, a user on a streak of losses may be given very favorable odds so that they are more likely to take the parlay wager and, therefore, also more likely to watch the next live event 31702. The parlay offer module 31724 may send, at step 31812, the parlay wager options to the mobile device 31708 to be selected via the wagering app 31710. Parlay wager options may combine the wager options on the current play and the wager options on the first play of the next live event 31702. For example, one parlay wager option may be a touchdown this play and heads on the coinflip of the next live event 31702, while another may also be a touchdown on this play, but tails on the coinflip of the next live event 31702. The parlay offer module 31724 may poll, at step 31814, for a placed wager from the mobile device 31708. The placed wager may include wager data such as which option was selected and how much was wagered. The parlay offer module 31724 may stop polling after the wagering window has closed. The parlay offer module 31724 may store, at step 31816, the placed wager in the user database 31716. The parlay offer module 31724 may return, at step 31818, to step 31800.

FIG. 319 illustrates the live event database 31726. The live event database 31726 may contain upcoming live events 31702. The live event database 31726 may contain a live event ID or another identifier. The live event database 31726 may contain a live event type such as baseball or football. The live event database 31726 may contain a start time or estimated start time. The live event database 31726 may contain additional details, such as the teams playing in the live event 31702.

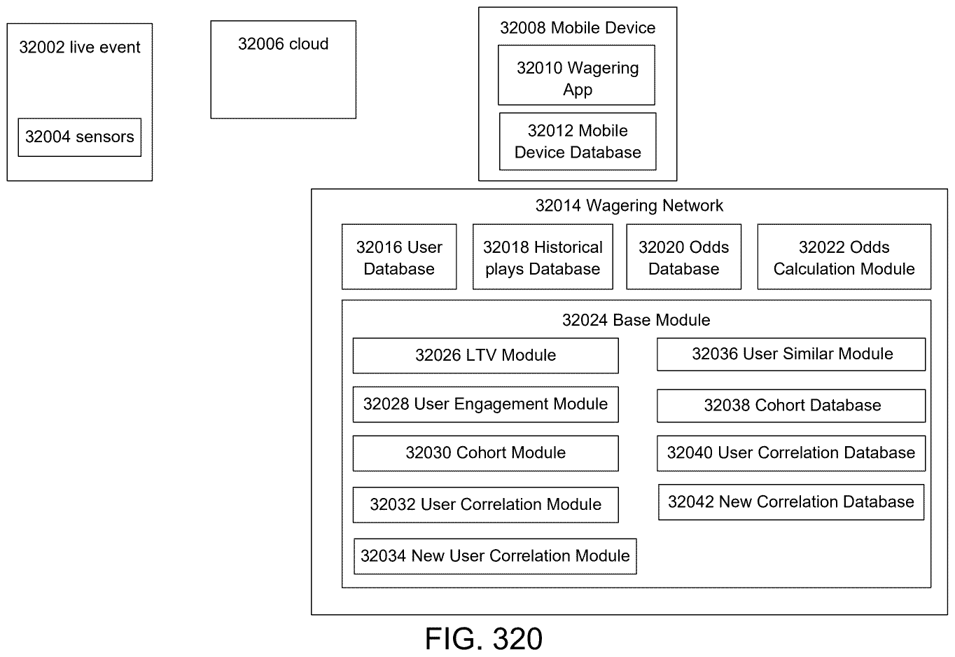

FIG. 320 illustrates a method for determining a user's long-term value and finding a similar new user, according to an embodiment.

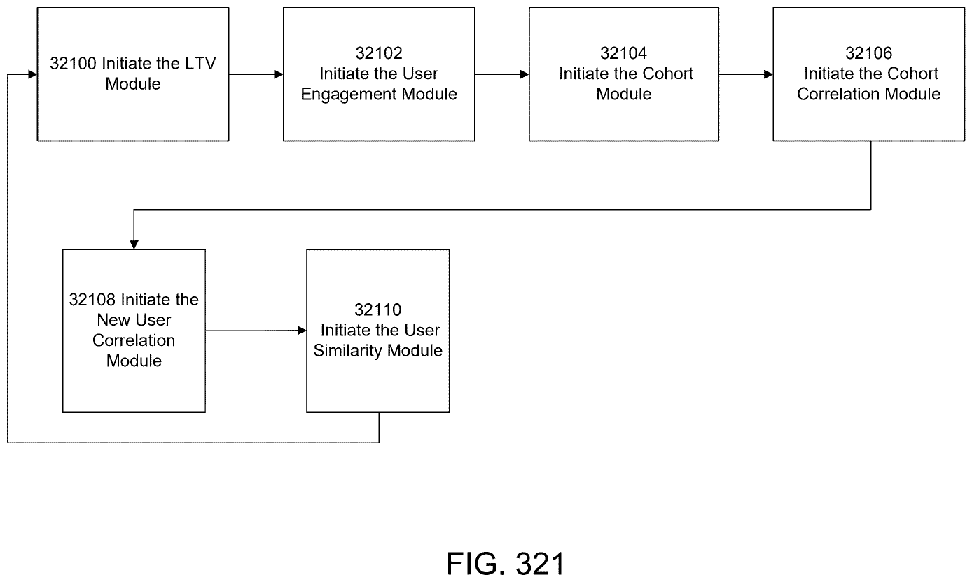

FIG. 321 illustrates a base module, according to an embodiment.

FIG. 322 illustrates an LTV module, according to an embodiment.

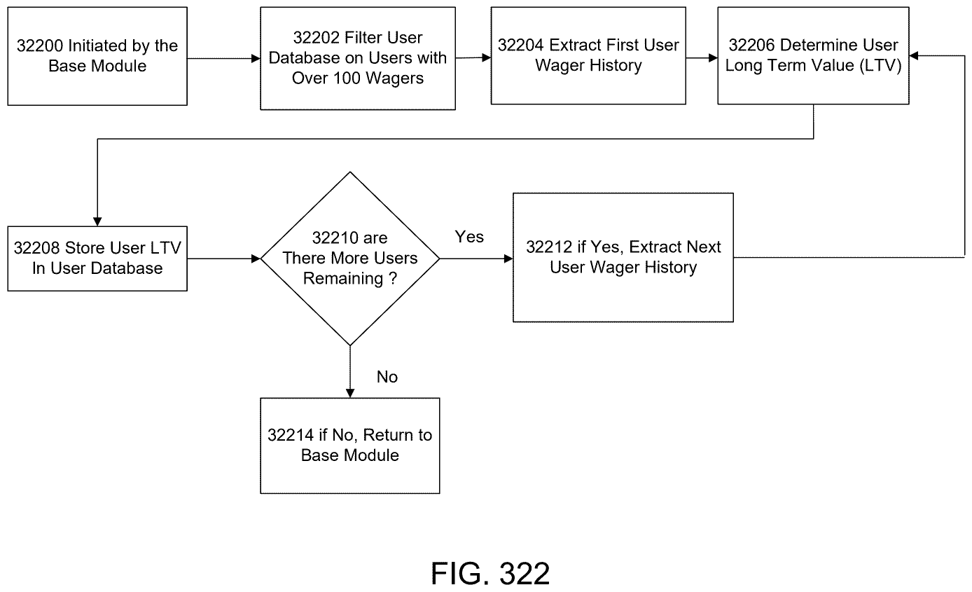

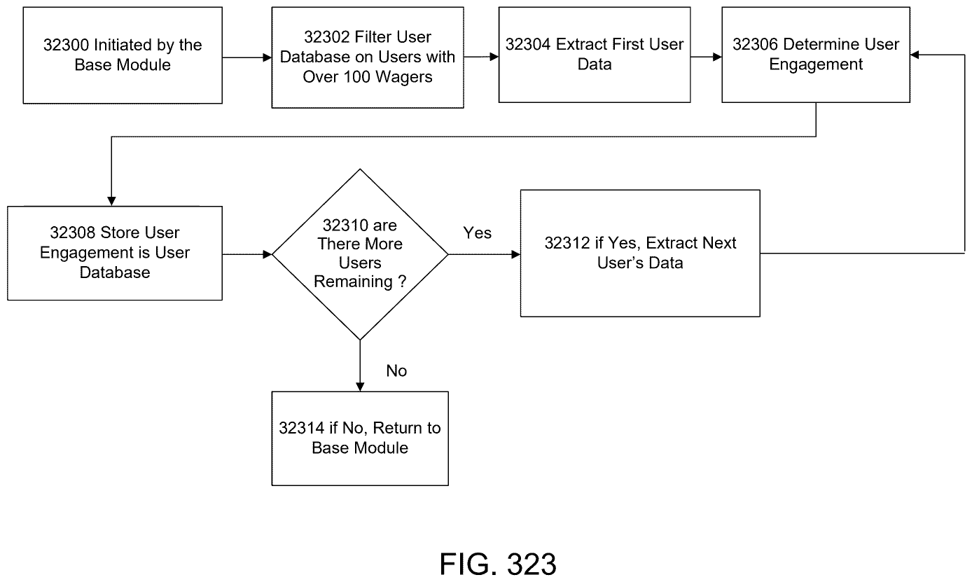

FIG. 323 illustrates a user engagement module, according to an embodiment.

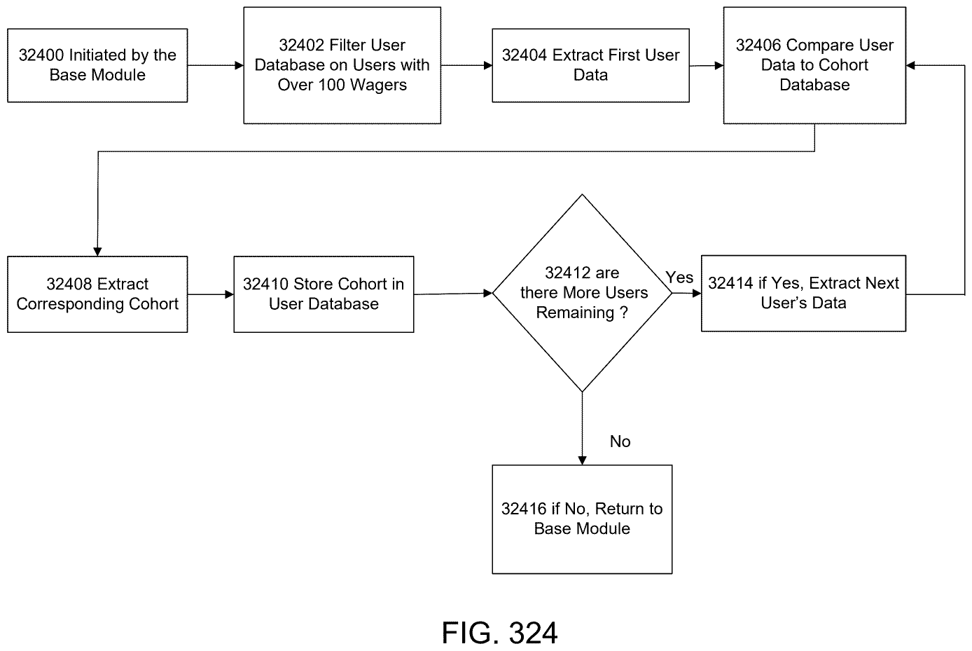

FIG. 324 illustrates a cohort module, according to an embodiment.

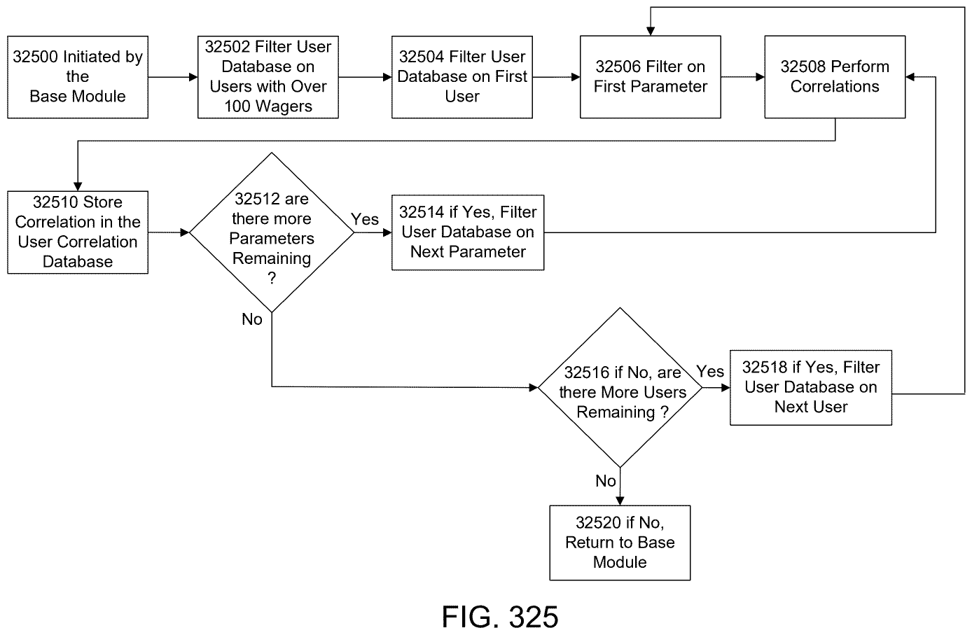

FIG. 325 illustrates a user correlation module, according to an embodiment.

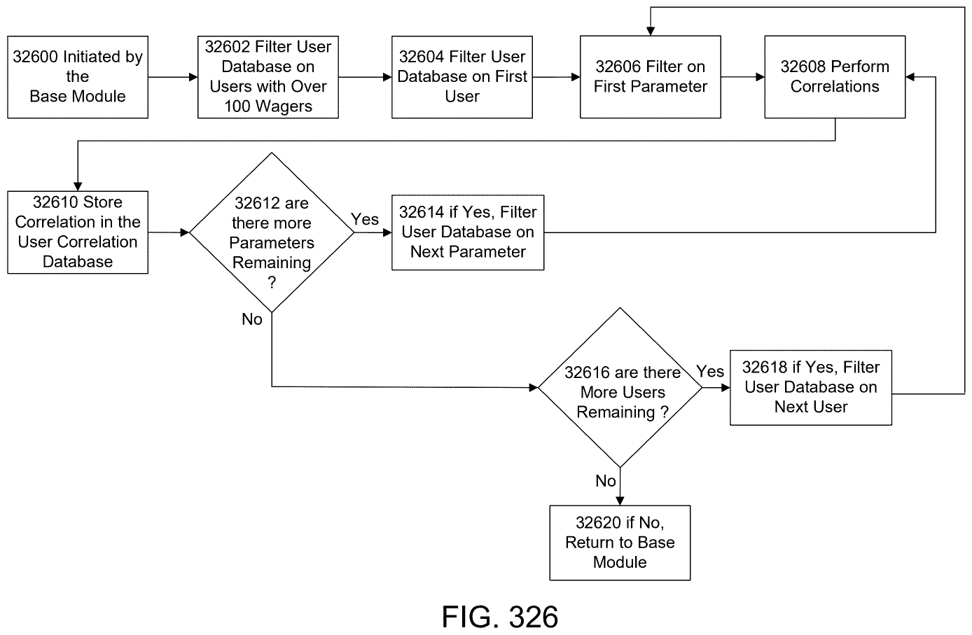

FIG. 326 illustrates a new user correlation module, according to an embodiment.

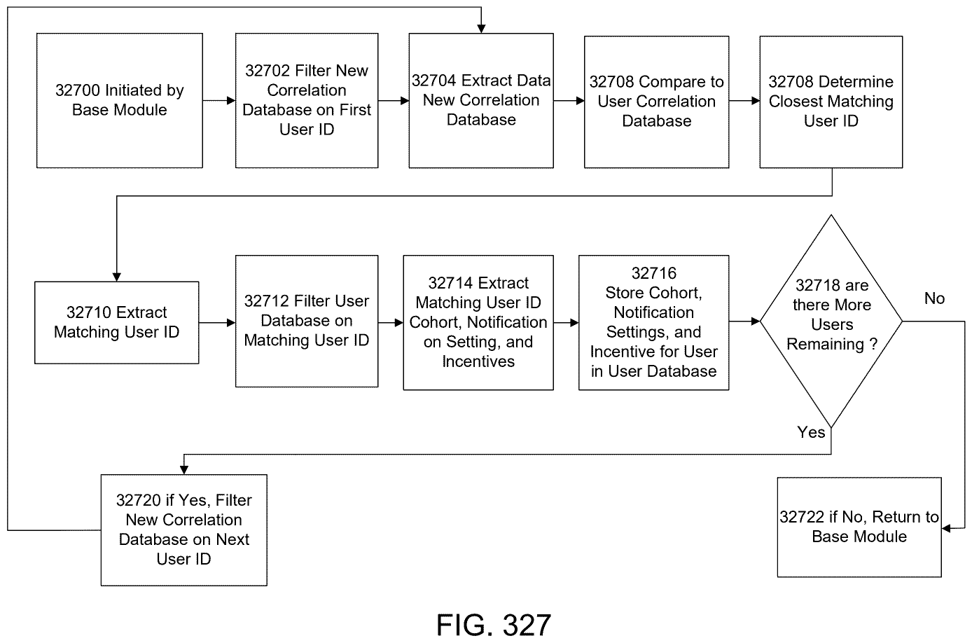

FIG. 327 illustrates a user similarity module, according to an embodiment.

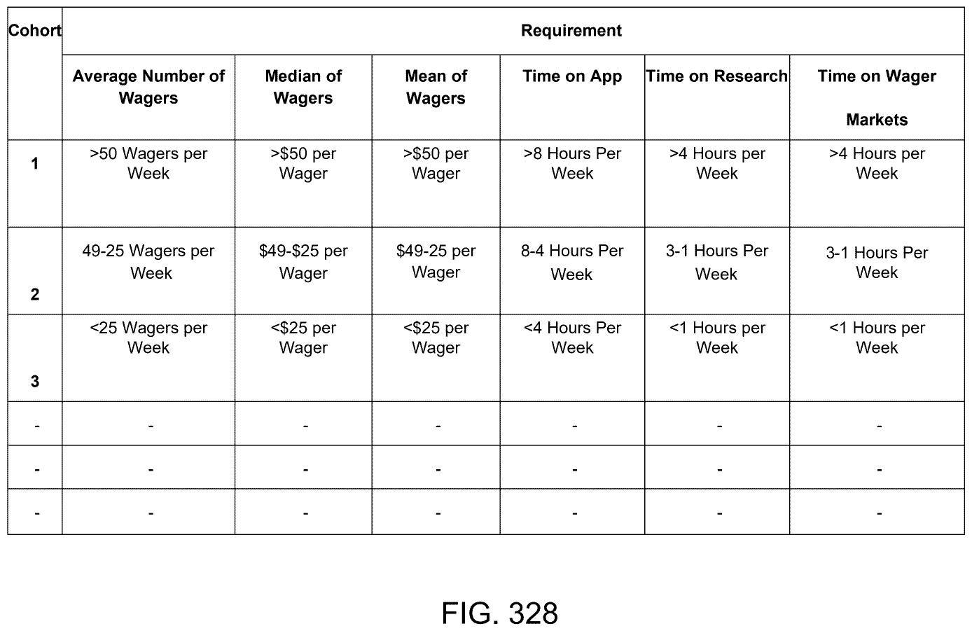

FIG. 328 illustrates a cohort database, according to an embodiment.

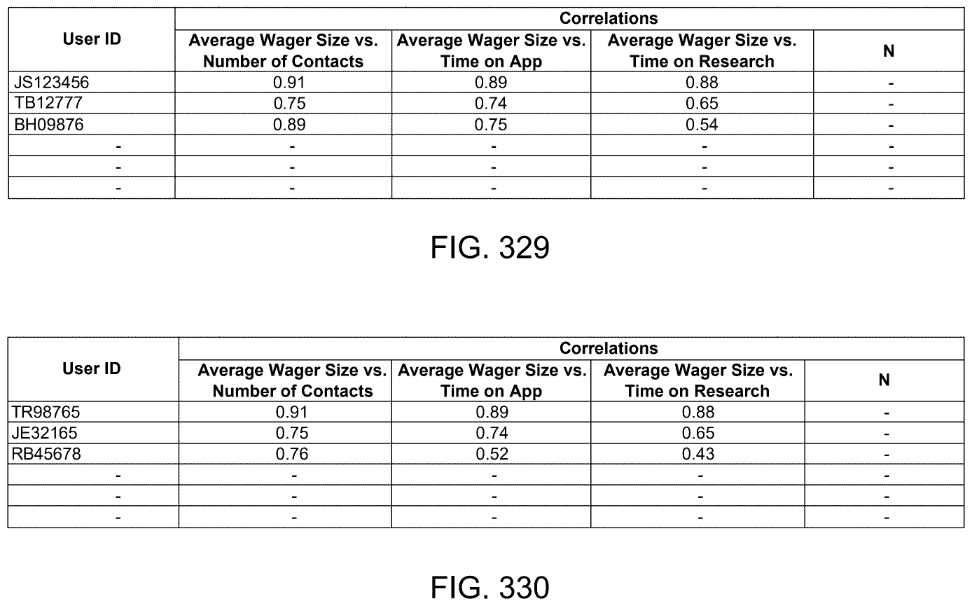

FIG. 329 illustrates a user correlation database, according to an embodiment.

FIG. 330 illustrates a new correlation database, according to an embodiment.

FIG. 320 is a method for determining a user's long-term value and finding a similar new user. This system may include a live event 32002, for example, a sporting event such as a football, basketball, baseball, or hockey game, tennis match, golf tournament, eSports or digital game, etc. The live event 32002 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 32002, such as the score of an American football game or the run line in a baseball game, or a series of actions in the live event 32002. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 32002 or at another location.

Further, embodiments may include a plurality of sensors 32004 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 32004 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 132006 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 32006 may be communicatively coupled to a peer-to-peer wagering network 32014, which may perform real-time analysis on the type of play and the result of the play. The cloud 32006 may also be synchronized with game situational data such as the time of the game, the score, location on the field, weather conditions, and the like, which may affect the choice of play utilized. For example, in an exemplary embodiment, the cloud 32006 may not receive data gathered from the sensors 32004 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 32008 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 32008 could be an optional component and would be utilized in a situation where a paired wearable device employs the mobile device 32008 for additional memory or computing power or connection to the internet.

Further, embodiments may include a wagering software application or a wagering app 32010, which is a program that enables the user to place bets on individual plays in the live event 32002, streams audio and video from the live event 32002, and features the available wagers from the live event 32002 on the mobile device 32008. The wagering app 32010 allows the user to interact with the wagering network 32014 to place bets and provide payment/receive funds based on wager outcomes.

Further, embodiments may include a mobile device database 32012 that may store some or all the user's data, the live event 32002, or the user's interaction with the wagering network 32014.

Further, embodiments may include the wagering network 32014, which may perform real-time analysis on the type of play and the result of a play or action. The wagering network 32014 (or the cloud 32006) may also be synchronized with game situational data, such as the time of the game, the score, location on the field, weather conditions, and the like, which may affect the choice of play utilized. For example, in an exemplary embodiment, the wagering network 32014 may not receive data gathered from the sensors 32004 and may, instead, receive data from an alternative data feed, such as SportsRadar®. This data may be provided substantially immediately following the completion of any play, and may be compared with a variety of team data and league data based on a variety of elements, including the current down, possession, score, time, team, and so forth, as described in various exemplary embodiments herein. The wagering network 32014 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 32016, which may contain data relevant to all users of the wagering network 32014 and may include, but is not limited to, a user ID, a device identifier, a paired device identifier, wagering history, or wallet information for the user. The user database 32016 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 32016 may contain betting lines and search queries. The user database 32016 may be searched based on a search criterion received from the user. Each betting line may include, but is not limited to, a plurality of betting attributes such as at least one of the live event 32002, a team, a player, an amount of wager, etc. The user database 32016 may include, but is not limited to, information related to all the users involved in the live event 32002. In one exemplary embodiment, the user database 32016 may include information for generating a user authenticity report and a wagering verification report. Further, the user database 32016 may be used to store user statistics like, but not limited to, the retention period for a particular user, frequency of wagers placed by a particular user, the average amount of wager placed by each user, etc.

Further, embodiments may include a historical plays database 32018 that may contain play data for the type of sport being played in the live event 32002. For example, in American Football, for optimal odds calculation, the historical play data may include metadata about the historical plays, such as time, location, weather, previous plays, opponent, physiological data, etc.

Further, embodiments may utilize an odds database 32020—that contains the odds calculated by an odds calculation module 32022—to display the odds on the user's mobile device 32008 and take bets from the user through the mobile device wagering app 32010.

Further, embodiments may include the odds calculation module 32022, which utilizes historical play data to calculate odds for in-play wagers.

Further, embodiments may include a base module 32024, which initiates a long-term value (LTV) module 32026, a user engagement module 32028, a cohort module 32030, a user correlation module 32032, a new user correlation module 32034, and a user similarity module 32036.

Further, embodiments may include the LTV module 32026, which filters the user database 32016 on users over a threshold number of wagers, such as 100 wagers. In some embodiments the threshold number of wagers may be a different number, such as 150 wagers, 200 wagers, or any other number. First, the LTV module 32026 extracts the first user's wager history. Then the LTV module 32026 determines the user's LTV to the wagering network 32014. The LTV module 32026 stores the user's LTV data in the user database 32016. Then the LTV module 32026 determines if more users remain in the user database 32016 who have completed over 100 wagers. If it is determined that more users are remaining, the LTV module 32026 extracts the next user's wager history from the user database 32016. If it is determined that there are no more users remaining, the LTV module 32026 returns to the base module 32024.

Further, embodiments may include the user engagement module 32028, which filters the user database 32016 on users over the threshold number of wagers, such as 100 wagers. In some embodiments the threshold number of wagers may be a different number, such as 150 wagers, 200 wagers, or any other number. First, the user engagement module 32028 extracts the first user's data from the user database 132016. Then the user engagement module 32028 determines the user's engagement on the wagering network 32014; the user engagement module 32028 stores the user's engagement data in the user database 32016. Then the user engagement module 32028 determines if more users remain in the user database 32016 who have completed over 100 wagers. If it is determined that more users are remaining, the user engagement module 32028 extracts the next user's data from the user database 32016. If it is determined that there are no more users remaining, the user engagement module 32028 returns to the base module 32024.

Further, embodiments may include the cohort module 32030 that filters the user database 32016 on users who have completed over the threshold number of wagers, such as 100 wagers. In some embodiments the threshold number of wagers may be a different number, such as 150 wagers, 200 wagers, or any other number. The cohort module 32030 extracts the first user's data from the user database 32016. Then the cohort module 32030 compares the extracted user's data to a cohort database 32038. The cohort module 32030 extracts the corresponding cohort from the cohort database 32038. Then the cohort module 32030 stores the extracted corresponding cohort in the user database 32016 with the associated user. Next, the cohort module 32030 determines if more users are remaining in the user database 32016. If it is determined that more users are remaining in the user database 32016, the cohort module 32030 extracts the next user's data from the user database 32016. If it is determined that there are no more users remaining in the user database with over 100 wagers, then the cohort module 32030 returns to the base module 32024.

Further, embodiments may include the user correlation module 32032, which filters the user database 32016 on users who have completed over the threshold number of wagers, such as 100 wagers. In some embodiments the threshold number of wagers may be a different number, such as 150 wagers, 200 wagers, or any other number. Then the user correlation module 32032 filters the user database 32016 on the first user. Then the user correlation module 32032 filters the user's data on the first parameter. Then the user correlation module 32032 performs correlations on the remaining parameters. Then the user correlation module 132032 stores the correlations in a user correlation database 32040. Then the user correlation module 32032 determines if more parameters are remaining. If it is determined that more parameters are remaining, the user correlation module 32032 filters the user database 32016 on the next parameter. If it is determined that there are no more parameters remaining for the filtered user in the user database 32016, the user correlation module 32032 determines if more users are remaining in the user database 32016. If it is determined that more users are remaining in the user database 32016, the user correlation module 32032 filters the user database 32016 on the next user and the process returns to filtering the user database 32016 on the first parameter. If it is determined that there are no more users remaining in the user database 32016, then the user correlation module 32032 returns to the base module 32024.

Further, embodiments may include the new user correlation module 32034, which filters the user database 32016 on users with under the threshold number of wagers, such as 100 wagers. In some embodiments the threshold number of wagers may be a different number, such as 150 wagers, 200 wagers, or any other number. Then the new user correlation module 32034 filters the user database 32016 on the first user. Then the new user correlation module 32034 filters the user's data on the first parameter. Then the new user correlation module 32034 performs correlations on the remaining parameters. Then the new user correlation module 32034 stores the correlations in the new correlation database 32042. Then the new user correlation module 32034 determines if more parameters are remaining. If it is determined that more parameters are remaining, the new user correlation module 32034 filters the user database 32016 on the next parameter. If it is determined that there are no more parameters remaining for the filtered user in the user database 32016, the new user correlation module 32034 determines if more users are remaining in the user database 32016. If it is determined that more users are remaining in the user database 32016, the new user correlation module 32034 filters the user database 32016 on the next user and the process returns to filtering the user database 32016 on the first parameter. If it is determined that there are no more users remaining in the user database 32016, then the new user correlation module 32034 returns to the base module 32024.

Further, embodiments may include the user similarity module 32036, which filters a new correlation database 32042 on the first user ID. Then the user similarity module 132036 extracts the user's data from the new correlation database 32042. First, the user similarity module 32036 compares the extracted user's data to the user correlation database 32040. Then the user similarity module 32036 determines the closest matching user ID. Then the user similarity module 32036 extracts the matching user ID. The user similarity module 32036 filters the user database 32016 on the matching user ID. Then the user similarity module 32036 extracts the matching user ID's cohort, notification settings, and incentives. The user similarity module 32036 then stores the extracted cohort, notification settings, and incentives in the user database 32016 for the matched user. Then the user similarity module 32036 determines if more users are remaining in the new correlation database 32042. If it is determined that more users are remaining in the new correlation database 32042, the user similarity module 32036 filters the new correlation module 32036 on the next user ID, and the process returns to extract the user's data from the new correlation database 32042. If it is determined that there are no more users remaining in the new correlation database 32042, then the user similarity module 32036 returns to the base module 32024.

Further, embodiments may include the cohort database 32038. The database contains the thresholds to determine a user's cohort and the corresponding cohort, for example, the cohort, and the requirements such as the average number of wagers per week, the median of wagers per week in dollar amounts, the mean of wagers per week in dollar amounts, the time the user spends on the application per week, the amount of time the user spends on research per week, the amount of time the user spends on the wager markets per week or the time the user is viewing the wagers offered by the application per week. The database is used in the process described in the cohort module 32030, in which the user's data stored in the user database 32016 is compared to these thresholds to determine which cohort the user belongs to. The cohorts may represent the type of player that the user is on the application, such as an expert, average, or beginner user, which may be used to determine the user's long-term value to the wagering network 32014. In some embodiments, the thresholds may have different periods such as per month, per quarter, per year, etc. In some embodiments, the user may need to exceed the thresholds for all the requirements stored in the cohort database 32038, a predetermined number of requirements, such as 3, or exceed the threshold of one requirement to be considered to be placed in the corresponding cohort.

Further, embodiments may include the user correlation database 32040. The database is created in the process described in the user correlation module 32032, in which the user's data is correlated with other types of user data, and the correlation coefficients are stored in the database. The database is also used in the user similarity module 32036 in which the users in this database may be matched with new users using the correlation coefficients stored in the new correlation database 32042 to determine how new users will behave on the wagering network by finding a similar user in the user correlation database 32040. The database contains the user IDs, such as JS 12345, the correlation coefficients of correlated data, such as the average wager size vs. the number of contacts the user has with a correlation coefficient of 0.91, the average wager size vs. the time the user spends on the application with a correlation coefficient of 0.89, or the average wager size vs. the time the user spends on research with a correlation coefficient of 0.88. “N” may be used to represent an infinite number of the potential correlation coefficients between two pieces of data stored in the database.

Further, embodiments may include the new correlation database 32042. The database is created in the process described in the new user correlation module 32034, in which the user's data is correlated with other types of user data, and the correlation coefficients are stored in the database. The database is also used in the user similarity module 32036 in which the new users in this database may be matched with users using the correlation coefficients stored in the user correlation database 32040 to determine how new users will behave on the wagering network by finding a similar user in the user correlation database 32040. The database contains the user IDs, such as TR98765, the correlation coefficients of correlated data, such as the average wager size vs. the number of contacts the user has with a correlation coefficient of 0.91, the average wager size vs. the time the user spends on the application with a correlation coefficient of 0.89, or the average wager size vs. the time the user spends on research with a correlation coefficient of 0.88. “N” may be used to represent an infinite number of the potential correlation coefficients between two pieces of data stored in the database.

FIG. 321 illustrates the base module 32024. The process begins with the base module 32024 initiating, at step 32100, the LTV module 32026. For example, the LTV module 32026 filters the user database 32016 on users over the threshold number of wagers, such as 100 wagers. In some embodiments the threshold number of wagers may be a different number, such as 150 wagers, 200 wagers, or any other number. The LTV module 32026 extracts the first user's wager history. Then the LTV module 32026 determines the user's LTV to the wagering network 32014. The LTV module 32026 stores the user's LTV data in the user database 32016. Then the LTV module 32026 determines if more users remain in the user database 32016 who have completed over the threshold number of wagers, such as 100 wagers. In some embodiments the threshold number of wagers may be a different number, such as 150 wagers, 200 wagers, or any other number. If it is determined that more users are remaining, the LTV module 32026 extracts the next user's wager history from the user database 32016. If it is determined that there are no more users remaining, the LTV module 32026 returns to the base module 32024. The base module 32024 initiates, at step 32102, the user engagement module 32028. For example, the user engagement module 32028 filters the user database 32016 on users with over the threshold number of wagers, such as 100 wagers. In some embodiments the threshold number of wagers may be a different number, such as 150 wagers, 200 wagers, or any other number. The user engagement module 32028 extracts the first user's data from the user database 32016. Then the user engagement module 32028 determines the user's engagement on the wagering network 32014. The user engagement module 32028 stores the user's engagement data in the user database 32016. Then the user engagement module 32028 determines if more users remain in the user database 32016 who have completed over the threshold number of wagers, such as 100 wagers. In some embodiments the threshold number of wagers may be a different number, such as 150 wagers, 200 wagers, or any other number. If it is determined that more users are remaining, the user engagement module 32028 extracts the next user's data from the user database 32016. If it is determined that there are no more users remaining, the user engagement module 32028 returns to the base module 32024. The base module 32024 initiates, at step 32104, the cohort module 32030. For example, the cohort module 32030 filters the user database 32016 on users that have completed over the threshold number of wagers, such as 100 wagers. In some embodiments the threshold number of wagers may be a different number, such as 150 wagers, 200 wagers, or any other number. The cohort module 32030 extracts the first user's data from the user database 32016. Then the cohort module 32030 compares the extracted user's data to the cohort database 32038. The cohort module 32030 extracts the corresponding cohort from the cohort database 138. Then the cohort module 32030 stores the extracted corresponding cohort in the user database 32016 with the associated user. The cohort module 32030 determines if more users are remaining in the user database 32016. If it is determined that more users are remaining in the user database 32016, the cohort module 32030 extracts the next user's data from the user database 32016. If it is determined that there are no more users remaining in the user database with over the threshold number of wagers, such as 100 wagers. In some embodiments the threshold number of wagers may be a different number, such as 150 wagers, 200 wagers, or any other number, then the cohort module 32030 returns to the base module 32024. The base module 32024 initiates, at step 32106, the user correlation module 32032. For example, the user correlation module 32032 filters the user database 32016 on users with over the threshold number of wagers, such as 100 wagers. In some embodiments the threshold number of wagers may be a different number, such as 150 wagers, 200 wagers, or any other number. Then the user correlation module 32032 filters the user database 32016 on the first user. The user correlation module 32032 filters the user's data on the first parameter. Then the user correlation module 32032 performs correlations on the remaining parameters. The user correlation module 32032 stores the correlations in the user correlation database 32040. Then the user correlation module 32032 determines if more parameters are remaining. If it is determined that more parameters are remaining, the user correlation module 32032 filters the user database 32016 on the next parameter. If it is determined that there are no more parameters remaining for the filtered user in the user database 32016, the user correlation module 32032 determines if more users are remaining in the user database 32016. If it is determined that more users are remaining in the user database 32016, the user correlation module 32032 filters the user database 32016 on the next user and the process returns to filtering the user database 32016 on the first parameter. If it is determined that there are no more users remaining in the user database 32016, then the user correlation module 32032 returns to the base module 32024. The base module 32024 initiates, at step 32108, the new user correlation module 32034. For example, the new user correlation module 32034 filters the user database 32016 on users with under the threshold number of wagers, such as 100 wagers. In some embodiments the threshold number of wagers may be a different number, such as 150 wagers, 200 wagers, or any other number. Then the new user correlation module 32034 filters the user database 32016 on the first user. The new user correlation module 32034 filters the user's data on the first parameter. Then the new user correlation module 32034 performs correlations on the remaining parameters. The new user correlation module 32034 stores the correlations in the new correlation database 32042. Then the new user correlation module 32034 determines if more parameters are remaining. If it is determined that more parameters are remaining, the new user correlation module 32034 filters the user database 32016 on the next parameter. If it is determined that there are no more parameters remaining for the filtered user in the user database 32016, the new user correlation module 32034 determines if more users are remaining in the user database 32016. If it is determined that more users are remaining in the user database 32016, the new user correlation module 32034 filters the user database 32016 on the next user and the process returns to filtering the user database 32016 on the first parameter. If it is determined that there are no more users remaining in the user database 32016, then the new user correlation module 32034 returns to the base module 32024. The base module 32024 initiates, at step 32110, the user similarity module 32036. For example, the user similarity module 32036 filters the new correlation database 32042 on the first user ID. Then the user similarity module 32036 extracts the user's data from the new correlation database 32042. The user similarity module 32036 compares the extracted user's data to the user correlation database 32040. Then the user similarity module 32036 determines the closest matching user ID. Then the user similarity module 32036 extracts the matching user ID. The user similarity module 32036 filters the user database 32016 on the matching user ID. Then the user similarity module 32036 extracts the matching user ID's cohort, notification settings, and incentives. The user similarity module 32036 stores the extracted cohort, notification settings, and incentives in the user database 32016 for the matched user. Then the user similarity module 32036 determines if more users are remaining in the new correlation database 32042. If it is determined that more users are remaining in the new correlation database 32042, the user similarity module 32036 filters the new correlation module 32036 on the next user ID, and the process returns to extract the user's data from the new correlation database 32042. If it is determined that there are no more users remaining in the new correlation database 32042, then the user similarity module 32036 returns to the base module 32024.

FIG. 322 illustrates the LTV module 32026. The process begins with the LTV module 32026 being initiated, at step 32200, by the base module 32024. Then the LTV module 32026 filters, at step 32202, the user database 32016 on users with over the threshold number of wagers, such as 100 wagers. In some embodiments the threshold number of wagers may be a different number, such as 150 wagers, 200 wagers, or any other number. The LTV module 32026 extracts, at step 32204, the first user's wager history. For example, the LTV module 32026 extracts the wagering history of the first user ID listed in the filtered user database 32016. Then the LTV module 32026 rates, at step 32206, the user's LTV to the wagering network 32014. For example, the LTV module 32026 rates the user's long-term value to the wagering network 32014 by using the user's wager history to determine the user's average number of wagers per week, the user's median of wagers per week in dollar amounts, and the user's mean of wagers per week in dollar amounts. Another period may be used in some embodiments, such as per month, per quarter, per year, etc. In some embodiments, the user's long-term value to the wagering network may be rated by how many friends the user invites to the wagering network 32014, how much money the user loses to the wagering network 32014, how much a user promotes the wagering network 32014 on other applications, etc. The LTV module 32026 stores, at step 32208, the user's LTV data in the user database 32016. For example, the user's average number of wagers per week, the user's median of wagers per week in dollar amounts, and the user's mean of wagers per week in dollar amounts are stored in the user database 32016. For example, user ID JS12345 may have an average number of wagers per week of 60, a median of wagers per week of $55 per wager, and a mean of wagers per week of $55 per wager, and this data is stored in the user database 32016. Then the LTV module 32026 determines, at step 32210, if more users remain in the user database 32016 that have completed over the threshold number of wagers, such as 100 wagers. In some embodiments the threshold number of wagers may be a different number, such as 150 wagers, 200 wagers, or any other number. For example, if there are remaining user IDs stored in the user database 32016 that have completed over the threshold number of wagers, such as 100 wagers. In some embodiments the threshold number of wagers may be a different number, such as 150 wagers, 200 wagers, or any other number. If is determined that more users are remaining the LTV module 32026 extracts, at step 32012, the next user's wager history from the user database 32016. If it is determined that there are no more users remaining, the LTV module 32026 returns, at step 32214, to the base module 32024.

FIG. 323 illustrates the user engagement module 32028. The process begins with the user engagement module 32028 being initiated, at step 32300, by the base module 32024. Then the user engagement module 32028 filters, at step 32302, the user database 32016 on users with over the threshold number of wagers, such as 100 wagers. In some embodiments the threshold number of wagers may be a different number, such as 150 wagers, 200 wagers, or any other number. Next, the user engagement module 32028 extracts, at step 32304, the first user's data from the user database 32016. For example, the user engagement module 32028 extracts the user data associated with the first user ID listed in the filtered user database 32016. Then the user engagement module 32028 determines, at step 32306, the user's engagement on the wagering network 32014. For example, user engagement may be determined by the amount of time a user spends on the application per week, the amount of time the user spends on research on the application per week, and the amount of time spent on the wager markets per week, such as reviewing or viewing the various wagers offered by the application. Finally, the user engagement module 32028 stores, at step 32308, the user's engagement data in the user database 32016. For example, if user ID JS12345 spends 10 hours on the application per week, 5 hours spent on researching on the application per week, and 5 hours spent on the wager markets per week, then this data is stored in the user database 32016. Then the user engagement module 32028 determines, at step 32310, if more users remain in the user database 32016 that have completed over the threshold number of wagers, such as 100 wagers. In some embodiments the threshold number of wagers may be a different number, such as 150 wagers, 200 wagers, or any other number. For example, if there are remaining user IDs stored in the user database 32016 that have completed over the threshold number of wagers, such as 100 wagers. In some embodiments the threshold number of wagers may be a different number, such as 150 wagers, 200 wagers, or any other number. If it is determined that more users are remaining, the user engagement module 32028 extracts, at step 32312, the next user's data from the user database 32016. If it is determined that there are no more users remaining, the user engagement module 32028 returns, at step 32314, to the base module 32024.

FIG. 324 illustrates the cohort module 32030. The process begins with the cohort module 32030 being initiated, at step 32400, by the base module 32024. Then the cohort module 32030 filters, at step 32402, the user database 32016 on users that have completed over the threshold number of wagers, such as 100 wagers. In some embodiments the threshold number of wagers may be a different number, such as 150 wagers, 200 wagers, or any other number. The cohort module 32030 extracts, at step 32404, the first user's data from the user database 32016. For example, the cohort module 32030 extracts the user data associated with the first user ID listed in the filtered user database 32016. Then the cohort module 32030 compares, at step 32406, the extracted user's data to the cohort database 32038. For example, the cohort module 32030 compares the user's average number of wagers per week, the user's median of wagers per week in dollar amounts, and the user's mean of wagers per week in dollar amounts, the amount of time a user spends on the application per week, the amount of time the user spends on research on the application per week, and amount of time spent on the wager markets per week, such as reviewing or viewing the various wagers offered by the application, to the cohort database 32038 which contains thresholds for each category to determine which cohort the user should be placed in either to allow the user to be categorized as an expert user, average user, or beginner user. The cohort module 32030 extracts, at step 32408, the corresponding cohort from the cohort database 32038. For example, if user ID JS12345 may have an average number of wagers per week of 60, a median of wagers per week of $55 per wager, and a mean of wagers per week of $55 per wager, spends an average of 10 hours on the application per week, 5 hours spent on researching on the application per week, and 5 hours spent on the wager markets per week. Then the user would be in cohort one, or the first cohort since the user's data is above all the threshold corresponding to cohort one in the cohort database 32038, so cohort one would be extracted. In some embodiments, the user may need to exceed the thresholds for all the requirements stored in the cohort database 32038, a predetermined number of requirements, such as 3, or exceed the threshold of one requirement to be considered to be placed in the corresponding cohort. Then the cohort module 32030 stores, at step 32410, the extracted corresponding cohort in the user database 32016 with the associated user. For example, the user ID JS12345 would be in cohort one, so this data would be stored in the user database 32016. The cohort module 32030 determines, at step 32412, if more users remain in the user database 32016. For example, if there are remaining user IDs stored in the user database 32016 that have completed over the threshold number of wagers, such as 100 wagers. In some embodiments the threshold number of wagers may be a different number, such as 150 wagers, 200 wagers, or any other number. If it is determined that more users are remaining in the user database 32016, the cohort module 32030 extracts, at step 32414, the next user's data from the user database 32016. If it is determined that there are no more users remaining in the user database with over the threshold number of wagers, such as 100 wagers. In some embodiments the threshold number of wagers may be a different number, such as 150 wagers, 200 wagers, or any other number, then the cohort module 32030 returns, at step 32416, to the base module 32024.

FIG. 325 illustrates the user correlation module 32032. The process begins with the user correlation module 32032 being initiated, at step 32500, by the base module 32024. The user correlation module 32032 filters, at step 32502, the user database 32016 on users with over the threshold number of wagers, such as 100 wagers. In some embodiments the threshold number of wagers may be a different number, such as 150 wagers, 200 wagers, or any other number. For example, the user database 32016 is filtered to include only users who have completed more than the threshold number of wagerings in their wager history to separate the users who have used the application before and the new users of the application. Then the user correlation module 32032 filters, at step 32504, the user database 32016 on the first user. The user correlation module 32032 filters, at step 32506, the user's data on the first parameter. For example, the first parameter may be the average wager size for the user. In some embodiments, the parameters may be the mean of wager for the user, the median of wager for the user, the number of contacts of the user, the user's time spent on the application, the amount of time the user has spent on research, etc. Then the user correlation module 32032 performs, at step 32508, correlations on the remaining parameters. For example, the user database 32016 is filtered on the user ID, and one of the parameters, such as the user's average wager size and then correlations are performed on the rest of the parameters with the selected parameter that has filtered the database, such as the number of contacts the user has, the amount of time the user spends on the application per week, and the time on research the user spends per week, etc. An example of correlated parameters is the user's average wager size vs. the number of contacts the user has with a 0.91 correlation coefficient, and this correlation is extracted and stored in the user correlation database 32040. Another example of correlated parameters is the user's average wager size vs. the amount of time the user spends on the application per week with a 0.89 correlation coefficient. This correlation is extracted and stored in the user correlation database 32040. An additional example of correlated parameters is the user's average wager size vs. the time on research the user spends per week with a 0.88 correlation coefficient, and this correlation is extracted and stored in the user correlation database 32040. The user correlation module 32032 stores, at step 32510, the correlations in the user correlation database 32040. For example, for user ID JS12345 the correlation coefficient of 0.91 for the user's average wager size vs. the number of contacts the user has, the correlation coefficient of 0.89 for the user's average wager size vs. the amount of time the user spends on the application per week, and the correlation coefficient of 0.88 for the user's average wager size vs. the time on research the user spends per week is stored in the user correlation database 32040. Then the user correlation module 32032 determines, at step 32512, if more parameters are remaining. If it is determined that more parameters are remaining, the user correlation module 32032 filters, at step 32514, the user database 32016 on the next parameter. If it is determined that there are no more parameters remaining for the filtered user in the user database 32016, the user correlation module 32032 determines, at step 32516, if more users are remaining in the user database 32016. If it is determined that more users are remaining in the user database 32016, the user correlation module 32032 filters, at step 32518, the user database 32016 on the next user, and the process returns to filtering the user database 32016 on the first parameter. If it is determined that there are no more users remaining in the user database 32016, then the user correlation module 32032 returns, at step 32520, to the base module 32024.

FIG. 326 illustrates the new user correlation module 32034. The process begins with the new user correlation module 32034 being initiated, at step 32600, by the base module 32024. The new user correlation module 32034 filters, at step 32602, the user database 32016 on users with under the threshold number of wagers, such as 100 wagers. In some embodiments the threshold number of wagers may be a different number, such as 150 wagers, 200 wagers, or any other number. For example, the user database 32016 is filtered to include only users who have completed less than the threshold number of wagers in their wager history to separate the users who have used the application before and the new users of the application. Then the new user correlation module 32034 filters, at step 32604, the user database 32016 on the first user. The new user correlation module 32034 filters, at step 32606, the user's data on the first parameter. For example, the first parameter may be the average wager size for the user. In some embodiments, the parameters may be the mean of wager for the user, the median of wager for the user, the number of contacts of the user, the user's time spent on the application, the amount of time the user has spent on research, etc. Then the new user correlation module 32034 performs, at step 32608, correlations on the remaining parameters. For example, the user database 32016 is filtered on the user ID, and one of the parameters, such as the user's average wager size and then correlations are performed on the rest of the parameters with the selected parameter that has filtered the database, such as the number of contacts the user has, the amount of time the user spends on the application per week, and the time on research the user spends per week, etc. An example of correlated parameters is the user's average wager size vs. the number of contacts the user has with a 0.91 correlation coefficient, and this correlation is extracted and stored in the new correlation database 32042. Another example of correlated parameters is the user's average wager size vs. the amount of time the user spends on the application per week with a 0.89 correlation coefficient, and this correlation is extracted and stored in the new correlation database 32042. An additional example of correlated parameters is the user's average wager size vs. the time on research the user spends per week with a 0.88 correlation coefficient, and this correlation is extracted and stored in the new correlation database 32042. The new user correlation module 32034 stores, at step 32610, the correlations in the new correlation database 32042. For example, for user ID TR98765, the correlation coefficient of 0.91 for the user's average wager size vs. the number of contacts the user has, the correlation coefficient of 0.89 for the user's average wager size vs. the amount of time the user spends on the application per week, and the correlation coefficient of 0.88 for the user's average wager size vs. the time on research the user spends per week is stored in the new correlation database 32042. Then the new user correlation module 32034 determines, at step 32612, if more parameters are remaining. If it is determined that more parameters are remaining, the new user correlation module 32034 filters, at step 32614, the user database 32016 on the next parameter. If it is determined that there are no more parameters remaining for the filtered user in the user database 32016, the new user correlation module 32034 determines, at step 32616, if more users are remaining in the user database 32016. If it is determined that more users are remaining in the user database 32016, the new user correlation module 32034 filters, at step 32618, the user database 32016 on the next user, and the process returns to filtering the user database 32016 on the first parameter. If it is determined that there are no more users remaining in the user database 32016, then the new user correlation module 32034 returns, at step 32620, to the base module 32024.

FIG. 327 illustrates the user similarity module 32036. The process begins with the user similarity module 32036 being initiated, at step 32700, by the base module 32024. The user similarity module 32036 filters, at step 32702, the new correlation database 32042 on the first user ID. Then the user similarity module 32036 extracts, at step 32704, the user's data from the new correlation database 32042. For example, for user ID TR98765, the correlation coefficient of 0.91 for the user's average wager size vs. the number of contacts the user has, the correlation coefficient of 0.89 for the user's average wager size vs. the amount of time the user spends on the application per week, and the correlation coefficient of 0.88 for the user's average wager size vs. the time on research the user spends per week is extracted from the new correlation database 32042. The user similarity module 32036 compares, at step 32706, the extracted user's data to the user correlation database 32040. For example, for user ID TR98765, the correlation coefficient of 0.91 for the user's average wager size vs. the number of contacts the user has, the correlation coefficient of 0.89 for the user's average wager size vs. the amount of time the user spends on the application per week, and the correlation coefficient of 0.88 for the user's average wager size vs. the time on research the user spends per week is compared to the data stored in the user correlation database 32040 to find a match for a user with similar correlation coefficients which can be determined that the user will have similar interests, wagering patterns, and long term value to the wagering network 32014. Then the user similarity module 32036 determines, at step 32708, the closest matching user ID. For example, user ID TR98765 and user ID JS12345 both have the same correlation coefficients of 0.91 for the user's average wager size vs. the number of contacts the user has, the correlation coefficient of 0.89 for the user's average wager size vs. the amount of time the user spends on the application per week, and the correlation coefficient of 0.88 for the user's average wager size vs. the time on research the user spends per week. The closest matching user ID may fall within a threshold variance of the extracted user's data. The threshold variance may not be required to have the exact correlation coefficients but could have closely similar correlation coefficients such as a difference of 0.01, 0.02, 0.03, etc. The threshold variance may be a percentage difference, such as +/−5% or +/−10%. Then the user similarity module 32036 extracts, at step 32710, the matching user ID. For example, the user ID JS12345 is extracted from the user correlation database 32040. The user similarity module 32036 filters, at step 32712, the user database 32016 on the matching user ID. For example, the user database 32016 is filtered on the user ID JS12345. Then the user similarity module 32036 extracts, at step 32714, the matching user ID's cohort, notification settings, and incentives. For example, the data extracted would show the user ID JS12345 cohort is cohort one, the notification settings may be for football wagers when a team enters the red zone or is within 20 yards of the endzone, and the incentives offered to the user, such as wagering on football when a team is within 25 yards of the endzone results increased odds such as 3:1 for the team to score a touchdown as opposed to 2:1. The user similarity module 32036 stores, at step 32716, the extracted cohort, notification settings, and incentives in the user database 32016 for the matched user. For example, for the user ID TR98765, the cohort of cohort 1, the notification settings may be for football wagers when a team enters the red zone or is within 20 yards of the endzone. The incentives offered to the user, such as wagering on football when a team is within 25 yards of the endzone, results in increased odds such as 3:1 for the team to score a touchdown as opposed to 2:1 is stored in the user database 32016 under the user ID TR98765. Then the user similarity module 32036 determines, at step 32718, if more users remain in the new correlation database 32042. If it is determined that more users are remaining in the new correlation database 32042, the user similarity module 32036 filters, at step 32720, the new correlation module 32036 on the next user ID, and the process returns to extracting the user's data from the new correlation database 32042. If it is determined that there are no more users remaining in the new correlation database 32042, then the user similarity module 32036 returns, at step 32722, to the base module 32024.

FIG. 328 illustrates the cohort database 32038. The database contains the thresholds to determine a user's cohort and the corresponding cohort, for example, the cohort, and the requirements such as the average number of wagers per week, the median of wagers per week in dollar amounts, the mean of wagers per week in dollar amounts, the time the user spends on the application per week, the amount of time the user spends on research per week, the amount of time the user spends on the wager markets per week or the time the user is viewing the wagers offered by the application per week. The database is used in the process described in the cohort module 32030, in which the user's data stored in the user database 32016 is compared to these thresholds to determine which cohort the user belongs to. The cohorts may represent the type of player the user is on the application, such as an expert, average, or beginner user, which may be used to determine the user's long-term value to the wagering network 32014. In some embodiments, the thresholds may have different periods such as per month, per quarter, per year, etc. In some embodiments, the user may need to exceed the thresholds for all the requirements stored in the cohort database 32038, a predetermined number of requirements, such as 3, or exceed the threshold of one requirement to be considered to be placed in the corresponding cohort.

FIG. 329 illustrates the user correlation database 32040. The database is created in the process described in the user correlation module 32032, in which the user's data is correlated with other types of user data, and the correlation coefficients are stored in the database. The database is also used in the user similarity module 32036 in which the users in this database may be matched with new users using the correlation coefficients stored in the new correlation database 32042 to determine how new users will behave on the wagering network by finding a similar user in the user correlation database 32040. In addition, the database contains the user IDs, such as JS 12345, the correlation coefficients of correlated data, such as the average wager size vs. the number of contacts the user has with a correlation coefficient of 0.91, the average wager size vs. the time the user spends on the application with a correlation coefficient of 0.89, or the average wager size vs. the time the user spends on research with a correlation coefficient of 0.88. “N” may be used to represent an infinite number of the potential correlation coefficients between two pieces of data stored in the database.

FIG. 330 illustrates the new correlation database 32042. The database is created in the process described in the new user correlation module 32034, in which the user's data is correlated with other types of user data, and the correlation coefficients are stored in the database. The database is also used in the user similarity module 32036 in which the new users in this database may be matched with users using the correlation coefficients stored in the user correlation database 32040 to determine how new users will behave on the wagering network by finding a similar user in the user correlation database 32040. In addition, the database contains the user IDs, such as TR98765, the correlation coefficients of correlated data, such as the average wager size vs. the number of contacts the user has with a correlation coefficient of 0.91, the average wager size vs. the time the user spends on the application with a correlation coefficient of 0.89, or the average wager size vs. the time the user spends on research with a correlation coefficient of 0.88. “N” may be used to represent an infinite number of the potential correlation coefficients between two pieces of data stored in the database.

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

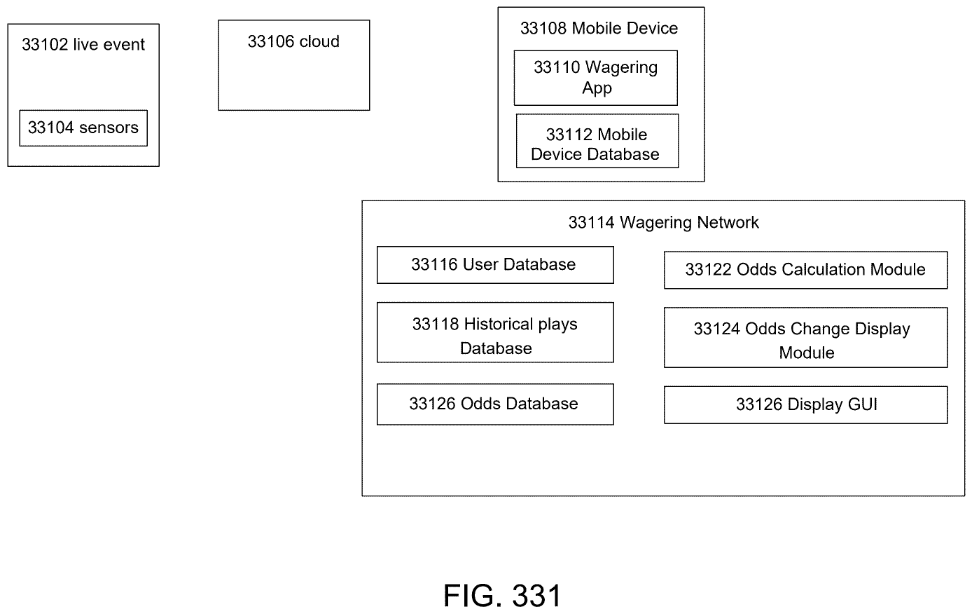

FIG. 331 illustrates a system for a real-time odds change indicator, according to an embodiment.

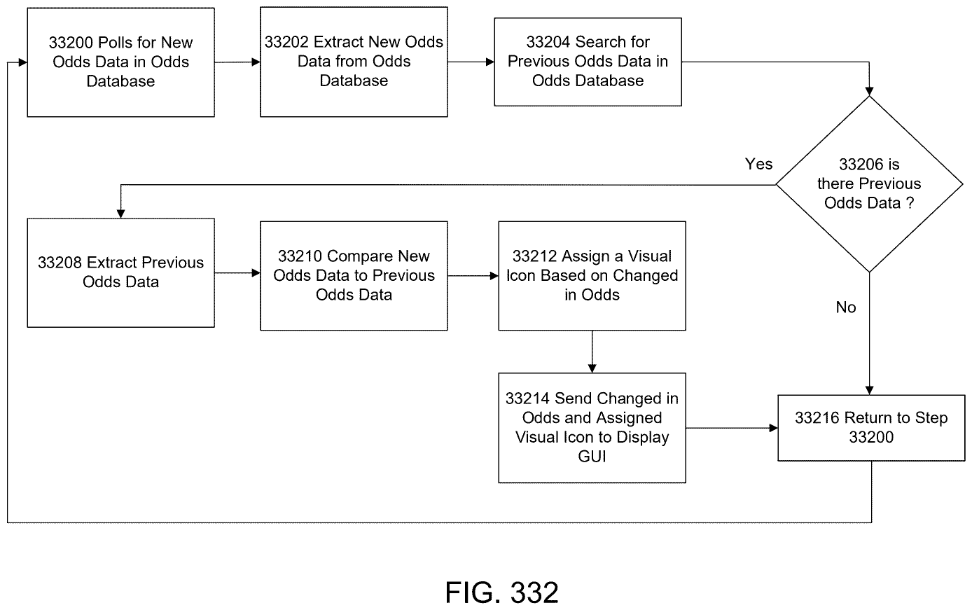

FIG. 332 illustrates an odds change display module, according to an embodiment.

FIG. 331 is a system for a real-time odds change indicator. This system may include a live event 33102, for example, a sporting event such as a football, basketball, baseball, or hockey game, tennis match, golf tournament, eSports, or digital game, etc. The live event 33102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 33102, such as the score of an American football game or the run line in a baseball game, or a series of actions in the live event 33102. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 33102 or at another location.

Further, embodiments may include a plurality of sensors 33104 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 33104 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 33106 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 33106 may be communicatively coupled to a peer-to-peer wagering network 33114, which may perform real-time analysis on the type of play and the result of the play. The cloud 33106 may also be synchronized with game situational data such as the time of the game, the score, location on the field, weather conditions, and the like, which may affect the choice of play utilized. For example, in an exemplary embodiment, the cloud 33106 may not receive data gathered from the sensors 33104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 33108 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 33108 could be an optional component and would be utilized in a situation where a paired wearable device employs the mobile device 33108 for additional memory or computing power or connection to the internet.

Further, embodiments may include a wagering software application or a wagering app 33110, which is a program that enables the user to place bets on individual plays in the live event 33102, streams audio and video from the live event 33102, and features the available wagers from the live event 33102 on the mobile device 33108. The wagering app 33110 allows the user to interact with the wagering network 33114 to place bets and provide payment/receive funds based on wager outcomes.

Further, embodiments may include a mobile device database 33112 that may store some or all the user's data, the live event 33102, or the user's interaction with the wagering network 33114.

Further, embodiments may include the wagering network 33114, which may perform real-time analysis on the type of play and the result of a play or action. The wagering network 33114 (or the cloud 33106) may also be synchronized with game situational data, such as the time of the game, the score, location on the field, weather conditions, and the like, which may affect the choice of play utilized. For example, in an exemplary embodiment, the wagering network 33114 may not receive data gathered from the sensors 33104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 33114 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 33116, which may contain data relevant to all users of the wagering network 33114 and may include, but is not limited to, a user ID, a device identifier, a paired device identifier, wagering history, or wallet information for the user. The user database 33116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 33116 may contain betting lines and search queries. The user database 33116 may be searched based on a search criterion received from the user. Each betting line may include but is not limited to, a plurality of betting attributes such as at least one of the following: the live event 33102, a team, a player, an amount of wager, etc. The user database 33116 may include, but is not limited to, information related to all the users involved in the live event 33102. In one exemplary embodiment, the user database 33116 may include information for generating a user authenticity report and a wagering verification report. Further, the user database 33116 may be used to store user statistics like, but not limited to, the retention period for a particular user, frequency of wagers placed by a particular user, the average amount of wager placed by each user, etc.

Further, embodiments may include a historical plays database 33118 that may contain play data for the type of sport being played in the live event 33102. For example, in American Football, for optimal odds calculation, the historical play data may include metadata about the historical plays, such as time, location, weather, previous plays, opponent, physiological data, etc.

Further, embodiments may utilize an odds database 33120—that may contain the odds calculated by an odds calculation module 33122—to display the odds on the user's mobile device 33108 and take bets from the user through the mobile device wagering app 33110.

Further, embodiments may include the odds calculation module 33122, which may utilize historical play data to calculate odds for in-play wagers.

Further, embodiments may include an odds change display module 33124, which may determine how the odds for a given wager option are changing in real-time and display that information via a display GUI 33126. The odds change display module 33124 may poll for changes in the odds database 33120, and determine the amount of change. Then, the change may be displayed, alongside a visual indicator such as a colored arrow, via the display GUI 33126.

Further, embodiments may include the display GUI 33126, which may display the change in odds for each wager option. The display GUI 33126 may be accessed by the mobile device 33108. The display GUI 33126 may be included in the mobile device 33108 or wagering app 33110.

FIG. 332 illustrates the odds change display module 33124. The process may begin with the odds change display module 33124 polling, at step 33200, for new odds data in the odds database 33120. New odds data may correspond to a change in odds data due to the new odds being calculated by the odds calculation module 33122. Odds may be recalculated in response to changes in data from the sensors 33104. If odds are stored in another system database or retrieved from a third party, then the odds change display module 33124 may poll for new odds data from those sources. Odds data may contain wager options, odds for each wager option, and a wager ID. The odds data may also contain a user ID if the odds are user-specific. The odds change display module 33124 may extract, at step 33202, the new odds data from the odds database 33120. The odds change display module 33124 may search, at step 33204, for previous odds data on the same wager in the odds database 33120. The extracted odds data may contain a wager ID or other identifier that can be used to find previous odds for the same wager. If the odds are specific to a user, then a user ID may be used to search for previous odds data for both the same user and wager. The odds change display module 33124 may determine, at step 33206, when there is previous odds data in the odds database 33120 for the wager. If not, the odds change display module may skip to step 33216. If there is previous odds data in the odds database for the wager, the odds change display module 33124 may extract, at step 33208, the previous odds data. Previous odds data may refer to the immediately previous odds, a subset of previous odds, or all previous odds for the wager. The odds change display module 33124 may compare, at step 33210, the new odds data to the previous odds data. The odds change display module 33124 may calculate a percentage difference between the new odds and the last odds. For example, if the last odds were 2:1 and the new odds are 2.2:1, then the odds have changed by +10%. The odds change display module 33124 may look at the average percentage increase over a set amount of time or odds changes. For example, the odds may have changed by an average of +5% over the last five changes or may have changed by an average of +5% over the last twenty seconds. The odds change display module 33124 may calculate the rate of change in odds over time, the absolute change in odds, whether the odds pass a predefined threshold, the rate of change between odds for different options on the same wager, etc. The odds change display module 33124 may assign, at step 33212, a visual icon based on the change in odds. For example, if the change in odds is positive, the odds change display module 33124 may assign a green arrow pointing up. If the change in odds is negative, the odds change module 33124 may assign a red arrow pointing down. The assigned visual icon may be altered based on the magnitude of the change. For example, the arrow may be larger, greener, or less opaque if the change is positive and has a larger magnitude while being smaller, less green, and more opaque if the change is positive and with a smaller magnitude. These visual icons may be stored in a visual icons database or the odds database. The odds change display module 33124 may assign variables that can then be used by the display GUI 33126 to create the visual icon. The odds change display module 33124 may send, at step 33214, the change in odds and an assigned visual icon to the display GUI 33126 to be displayed to the user. The change in odds may be displayed as text or be incorporated into a graphic such as a chart or a graph. The odds change display module 33124 may return, at step 33216, to step 33200.

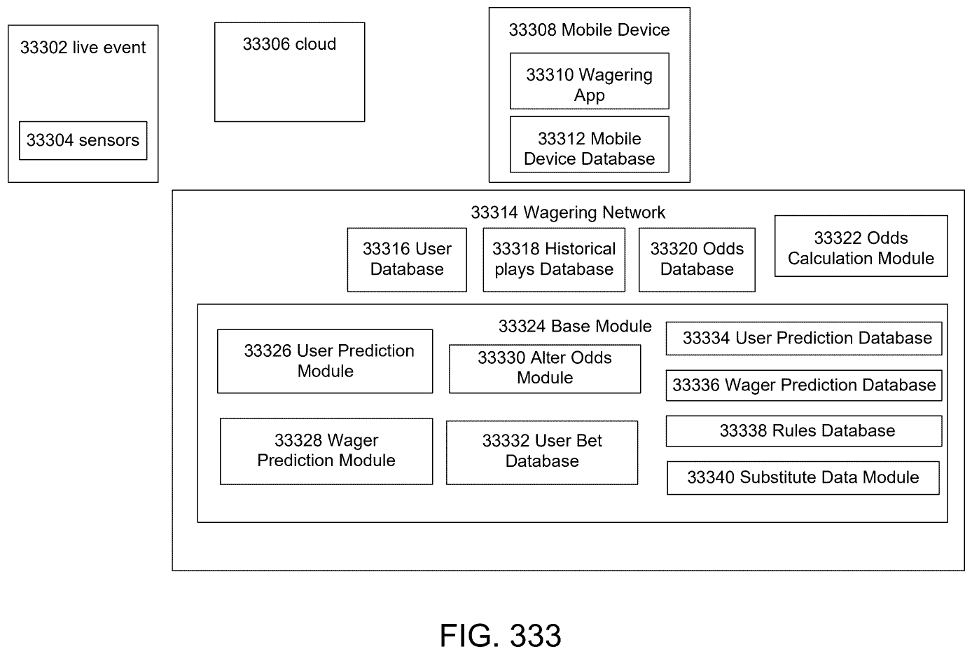

FIG. 333 illustrates a system for indirect odds making, according to an embodiment.

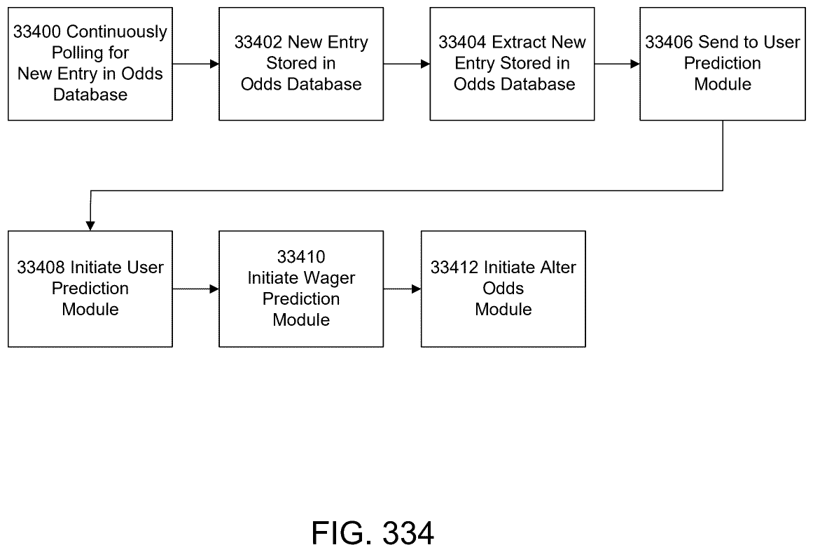

FIG. 334 illustrates a base module, according to an embodiment.

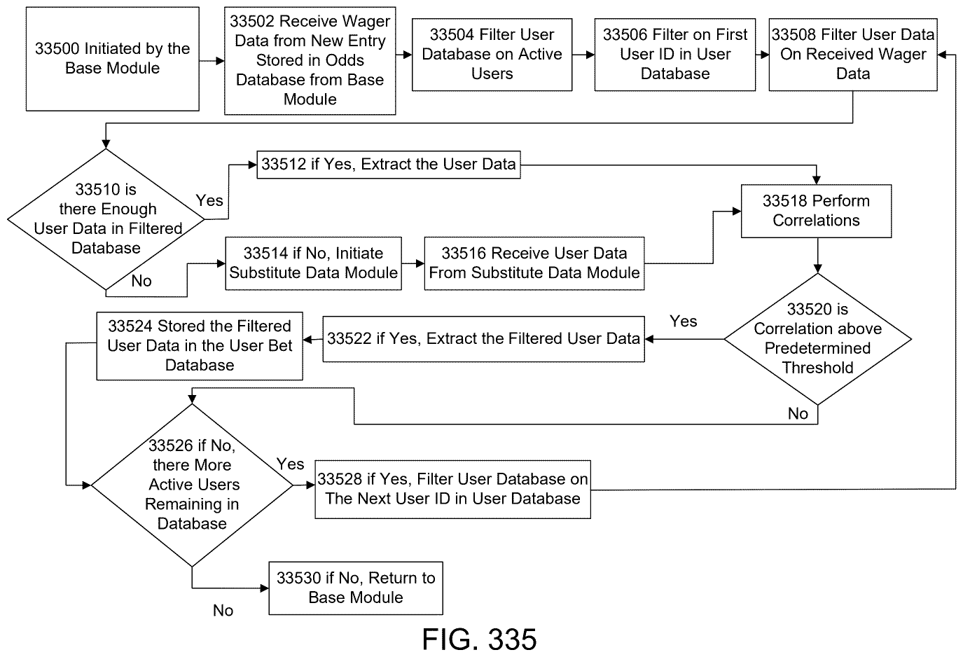

FIG. 335 illustrates a user prediction module, according to an embodiment.

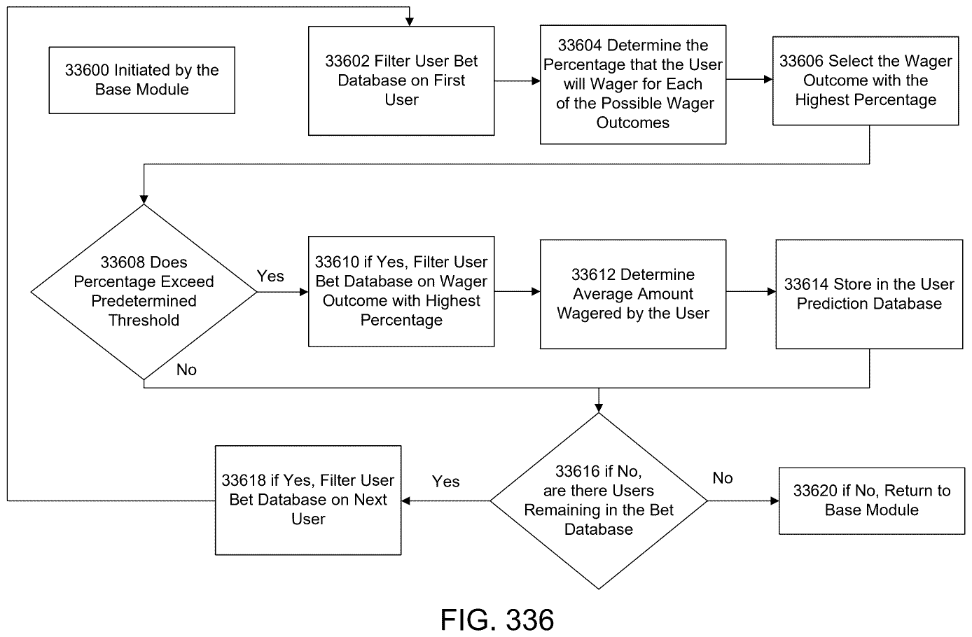

FIG. 336 illustrates a wager prediction module, according to an embodiment.

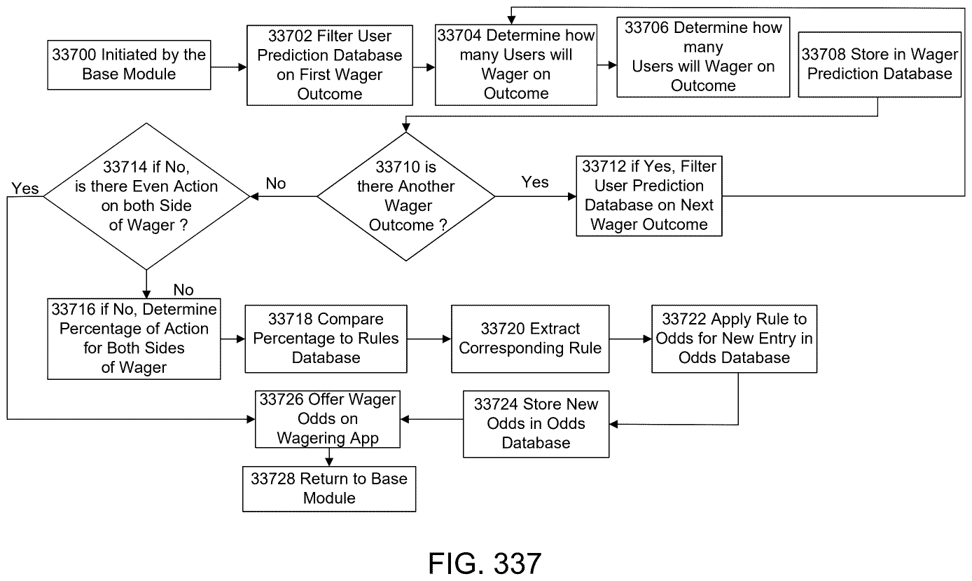

FIG. 337 illustrates an alter odds module, according to an embodiment.

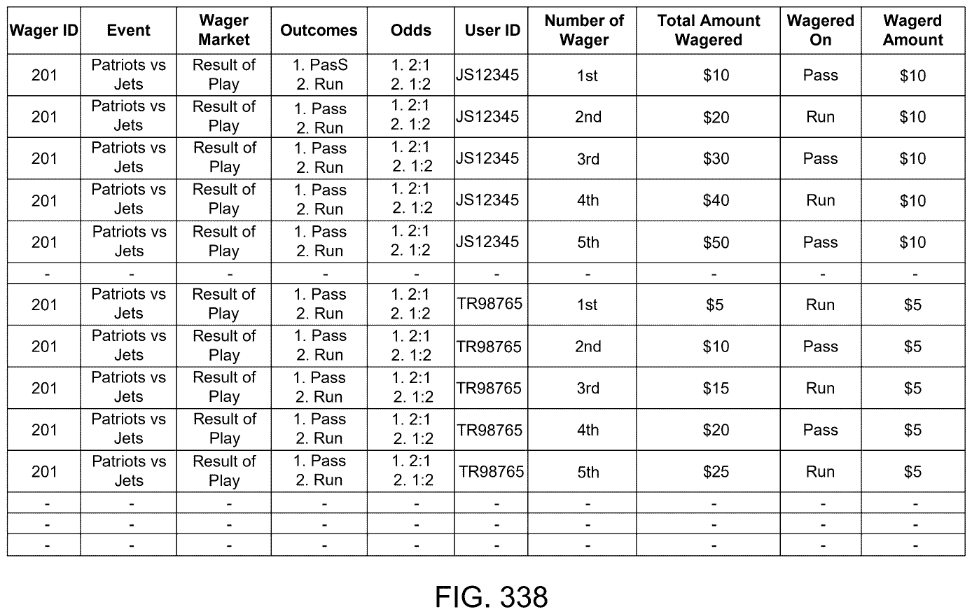

FIG. 338 illustrates a user bet database, according to an embodiment.

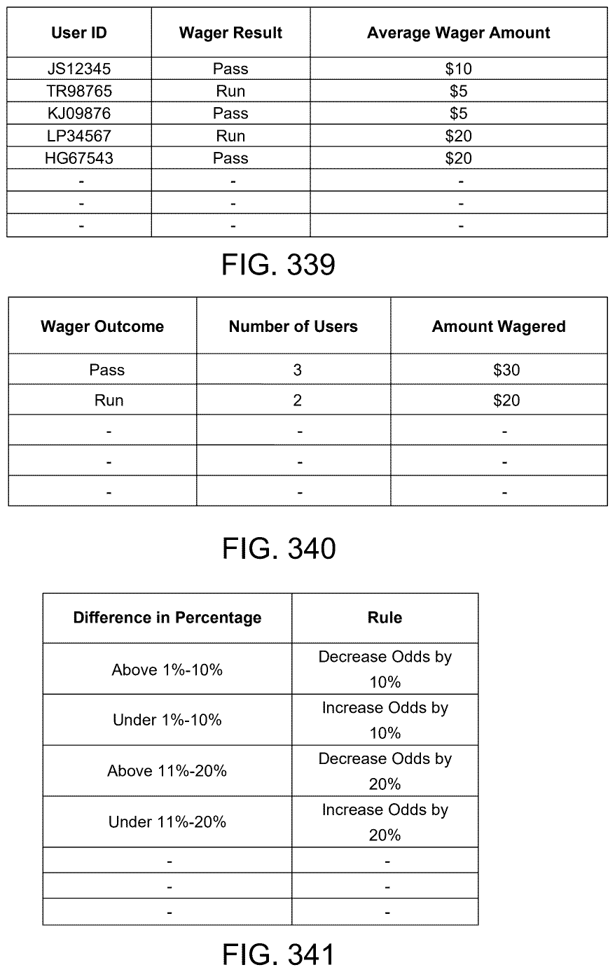

FIG. 339 illustrates a user prediction database, according to an embodiment.

FIG. 340 illustrates a wager prediction database, according to an embodiment.

FIG. 341 illustrates a rules database, according to an embodiment.

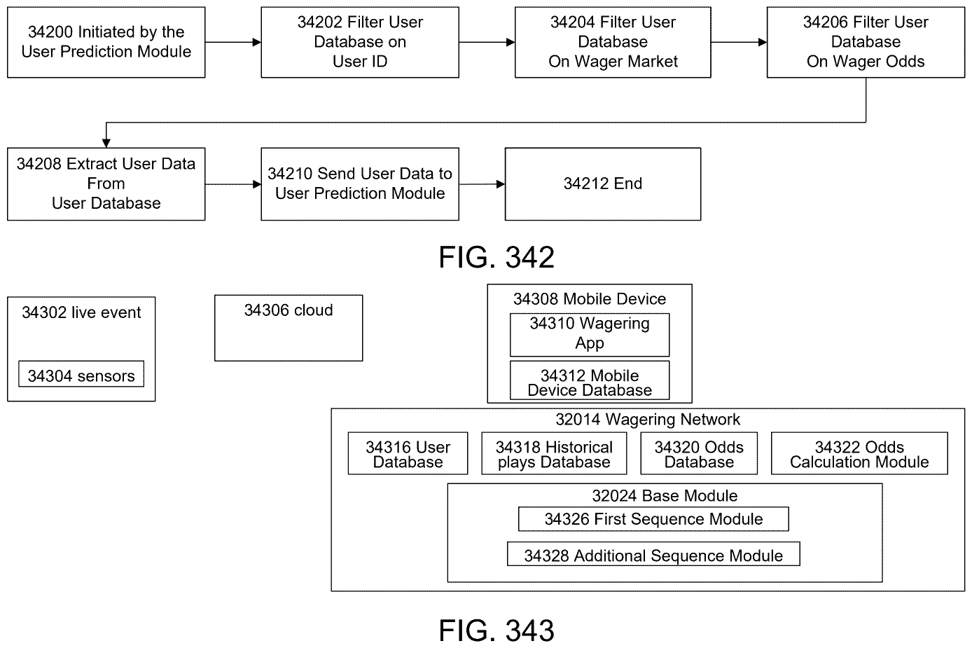

FIG. 342 illustrates a substitute data module, according to an embodiment.

FIG. 333 is a system for indirect odds making. This system may include a live event 33302, for example, a sporting event such as a football, basketball, baseball, or hockey game, tennis match, golf tournament, eSports, or digital game, etc. The live event 33302 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 33302, such as the score of an American football game or the run line in a baseball game, or a series of actions in the live event 33302. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 33302 or at another location.

Further, embodiments may include a plurality of sensors 33304 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 33304 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 33306 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 33306 may be communicatively coupled to a peer-to-peer wagering network 33314, which may perform real-time analysis on the type of play and the result of the play. The cloud 33306 may also be synchronized with game situational data such as the time of the game, the score, location on the field, weather conditions, and the like, which may affect the choice of play utilized. For example, in an exemplary embodiment, the cloud 33306 may not receive data gathered from the sensors 33304 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 33308 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 33308 could be an optional component and may be utilized in a situation where a paired wearable device employs the mobile device 33308 for additional memory or computing power or connection to the internet.

Further, embodiments may include a wagering software application or a wagering app 33310, which is a program that enables the user to place bets on individual plays in the live event 33302, streams audio and video from the live event 33302, and features the available wagers from the live event 33302 on the mobile device 33308. The wagering app 33310 allows the user to interact with the wagering network 33314 to place bets and provide payment/receive funds based on wager outcomes.

Further, embodiments may include a mobile device database 33312 that may store some or all the user's data, the live event 33302, or the user's interaction with the wagering network 33314.

Further, embodiments may include the wagering network 33314, which may perform real-time analysis on the type of play and the result of a play or action. The wagering network 33314 (or the cloud 33306) may also be synchronized with game situational data, such as the time of the game, the score, location on the field, weather conditions, and the like, which may affect the choice of play utilized. For example, in an exemplary embodiment, the wagering network 33314 may not receive data gathered from the sensors 33304 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 33314 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 33316, which may contain data relevant to all users of the wagering network 33314 and may include, but is not limited to, a user ID, a device identifier, a paired device identifier, wagering history, or wallet information for the user. The user database 33316 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 33316 may contain betting lines and search queries. The user database 33316 may be searched based on a search criterion received from the user. Each betting line may include but is not limited to, a plurality of betting attributes such as at least one of the following: the live event 33302, a team, a player, an amount of wager, etc. The user database 33316 may include, but is not limited to, information related to all the users involved in the live event 33302. In one exemplary embodiment, the user database 33316 may include information for generating a user authenticity report and a wagering verification report. Further, the user database 33316 may be used to store user statistics like, but not limited to, the retention period for a particular user, frequency of wagers placed by a particular user, the average amount of wager placed by each user, etc.

Further, embodiments may include a historical plays database 33318 that may contain play data for the type of sport being played in the live event 33302. For example, in American Football, for optimal odds calculation, the historical play data may include metadata about the historical plays, such as time, location, weather, previous plays, opponent, physiological data, etc.

Further, embodiments may utilize an odds database 33320—that may contain the odds calculated by an odds calculation module 33322—to display the odds on the user's mobile device 33308 and take bets from the user through the mobile device wagering app 33310.

Further, embodiments may include the odds calculation module 33322, which may utilize historical play data to calculate odds for in-play wagers. may be

Further, embodiments may include a base module 33324, which may begin with the base module 33324 continuously polling for a new entry to be stored in the odds database 33320. Then a new entry may be stored in the odds database 33320. The base module 33324 may extract the new entry stored in the odds database 33320. Then the base module 33324 may send the wager data from the new entry stored in the odds database 33320 to the user prediction module 33326. Then the base module 33324 may initiate the user prediction module 33326. The base module 33324 may initiate the wager prediction module 33328. Then the base module 33324 may initiate the alter odds module 33330, and the process may return to continuously polling for a new entry to be stored in the odds database 33320.

Further, embodiments may include a user prediction module 33326, which may begin with the user prediction module 33326 being initiated by the base module 33324. The user prediction module 33326 may receive the wager data from the new entry stored in the odds database 33320 from the base module 33324. Then the user prediction module 33326 may filter the user database 33316 on the active users. The user prediction module 33326 may filter the user database 33316 on the first user ID currently active on the wagering network 33314. Then the user prediction module 33326 may filter the user database 33316 on the received wager data from the new entry stored in the odds database 33318 from the base module 33324. The user prediction module 33326 may determine if there is enough user data in the filtered user database 33316. If there is enough user data in the filtered user database 33316, then the user prediction module 33326 may extract the user data stored in the user database 33316 that has been filtered by the active users on the wagering network 33314, the user ID, and the received wager data from the new entry stored in the odds database 33318. If there is not enough user data in the filtered user database 33316, then the user prediction module 33326 may initiate the substitute data module 33340. Then the user prediction module 33326 may receive the user data from the substitute data module 33340. The user prediction module 33326 may perform correlations on the extracted data. Then the user prediction module 33326 may determine if the correlations are above a predetermined threshold. If the correlations are above the predetermined threshold, then the user prediction module 33326 may extract the filtered user data. Then the user prediction module 33326 may store the filtered user data in the user bet database 33332. If the correlations are not above the predetermined threshold or after the filtered user data is stored in the user bet database 33332, the user prediction module 33326 may determine if there are more active users remaining on the wagering network 33314. If there are more active users remaining on the wagering network, the user prediction module 33326 may filter the user database 33316 on the next user ID, and the process may return to further filtering the user database 33316 on the received wager data of the new entry stored in the odds database 33318. If there are no more active users remaining on the wagering network 33314, then the user prediction module 33326 may return to the base module 33324.

Further, embodiments may include a wager prediction module 33328, which may begin with the wager prediction module 33328 being initiated by the base module 33324. Then the wager prediction module 33328 may filter the user bet database 33332 on the first user ID. Then the wager prediction module 33328 may determine a likelihood, probability or percentage that the user will wager on each possible wager outcome. Then the wager prediction module 33328 may select the wager outcome with the highest probability, likelihood, or percentage. Then the wager prediction module 33328 may determine if the probability, likelihood, or percentage exceeds the predetermined threshold. If the probability, likelihood, or percentage exceeds the predetermined threshold, then the wager prediction module 33328 may filter the user bet database 33332 on the wager outcome with the highest probability, likelihood, or percentage. Then the wager prediction module 33328 may determine the average amount wagered by the user on the wager outcome with the highest probability, likelihood, or percentage. The wager prediction module 33328 may store the data in the user prediction database 33334. If the probability, likelihood, or percentage does not exceed the predetermined threshold or after the data is stored in the user prediction database 33334, the wager prediction module 33328 may determine if more users are remaining in the user bet database 33332. If more users are remaining in the user bet database 33332, then the wager prediction module 33328 may filter the user bet database 33332 on the next user ID, and the process may return to determining the probability, likelihood, or percentage that the user will wager for each of the possible wager outcomes. If there are no more users remaining in the user bet database 132, the wager prediction module 33328 may return to the base module 33324.

Further, embodiments may include an alter odds module 33330, which may begin with the alter odds module 33330 initiated by the base module 33324. The alter odds module 33330 may filter the user prediction database 33336 on the first wager outcome. Then the alter odds module 33330 may determine how many users will wager on the wager outcome. Then the alter odds module 33330 may determine how much the users will wager on the wager outcome. First, the alter odds module 33330 may store how many users will wager and how much the users will wager in the wager prediction database 33336. Then the alter odds module 33330 may determine if another wager outcome is stored in the user prediction database 33334. If there is another wager outcome stored in the user prediction database 33334, then the alter odds module 33330 may filter the user prediction database 33334 on the next wager outcome, and the process may return to determine how many users will wager on the wager outcome. If no more wager outcomes are remaining in the user prediction database 33334, then the alter odds module 33330 may determine if there is even action on both sides of the wager. If there is not even action on both sides of the wager, then the alter odds module 33330 may determine the percentages for action for both sides of the wager. Then the alter odds module 33330 may compare the difference in the percentages to the rules database 33338. Next, the alter odds module 33330 may extract the corresponding rule stored in the rules database 33338. Then the alter odds module 33330 may apply the extracted rule to the wager odds for the new entry stored in the odds database 33318. Then the alter odds module 33330 may store the new odds for the wager in the odds database 33318. If there is even action on both sides of the wager or after the new odds are stored in the odds database 33318, then the alter odds module 33330 may offer the wager odds on the wagering app 33310. Then the alter odds module 33330 may return to the base module 33324.

Further, embodiments may include a user bet database 33332, which may contain the wager ID, the event, the wagering market, the possible outcomes for the wager, the odds for the wager, the user ID, the number of the wager in sequential order, the total amount wagered, the outcome wagered on, and the amount wagered for the wager. For example, the user bet database 33332 may store the wager data from the odds database 33320 such as the wager ID, such as 201, the event, such as the New England Patriots vs. the New York Jets, the outcomes for the wager, such as the first outcome being a pass and the second outcome being a run, and the odds for the possible outcomes, such as the odds of 2:1 for the outcome to be a pass and the odds 1:2 for the outcome to be a run. For example, the user bet database 33332 may store the filtered user data from the user database 33316 as described in the user prediction module 33326, which may contain the user ID, such as JS12345, the number of the wager in sequential order, such the users first wager, second wager, third wager, etc., the total amount wagered up to that point in time, such as $10 wagered total, $20 wagered total, etc., the outcome that the user wagered on, such as pass or run, and the amount that the user wagered on that individual wager, such as $10. In some embodiments, the user bet database 33332 may contain the correlation coefficients calculated during the user prediction module 33326. In some embodiments, the user bet database 33332 may contain the predetermined threshold of the correlation coefficient to determine if the data should be stored in the database or not.

Further, embodiments may include a user prediction database 33334, which may contain the user ID, the wager result, and the average amount wagered and may be created during the process described in the wager prediction module 33328 and may be used in the process described in the alter odds module 33330. For example, the user prediction database 33334 may contain the user ID, such as JS12345, the wager result, such as pass, and the average amount wagered by the user, such as $10.

Further, embodiments may include a wager prediction database 33336, which may be created in the process described in the alter odds module 33330 and may contain the wager outcome, such as a pass, the number of users that will wager on that outcome, such as three users will wager on a pass, and the amount wagered on the outcome, such as there will be $30 wagered on the pass. Finally, in some embodiments, there may be additional wager outcomes in which the process described in the alter odds module 33330 may determine, for each possible wager outcome, the number of users that will wager on the wager outcome and the amount that will be wagered on the wager outcome.

Further, embodiments may include a rules database 33338 that may contain the difference in percentages between the possible wager outcomes and the rule applied to the wagering odds. For example, if there are two possible wager outcomes, such as pass and run, and there is 60% of the money on the pass wagers and only 40% of the money on run wagers, there is not even action on both sides of the wager, an ideal percentage may be 50% of wagers or money on one side and 50% of wagers or money on the other side. So, the difference in percentages may be 20%, so the 2:1 odds for a pass may be above 20%, and the corresponding rule may be to decrease the odds by 20% so that the 2:1 odds for a pass would drop to 1.6:1 odds for the outcome to be a pass. Likewise, the difference may be under 20% for the run wager, and the odds for a run may be altered from 1:2 odds to 1:1.6 odds since the corresponding rule may be to increase the odds by 20%.

Further, embodiments may include a substitute data module 33340, which may begin with the substitute data module 33340 initiated by the user prediction module 33326. For example, if there is not enough user data in the filtered user database 33316, then the user prediction module 33326 may initiate the substitute data module 33340, which may filter the user database 33316 to provide enough user data, for example, over 25 entries, to the user prediction module 33326 to perform correlations on the user data. In some embodiments, the user prediction module 33326 may send the user ID and the received wager data to the substitute data module 33340. Then the substitute data module 33340 may filter the user database 33316 on the user ID. For example, the substitute data module 33340 may filter the user database on user ID JS12345. The substitute data module 33340 may filter the user database 33316 on the wagering market. For example, the substitute data module 33340 may filter the user database 33316 on the user ID and the received wager market from the wager data received from the user prediction module 33326, such as the result of a play. Then the substitute data module 33340 may filter the user database 33316 on the wager odds. For example, the substitute data module 33340 may filter the user database 33316 on the user ID, the wagering market, and the received wager odds from the user prediction module 33326, such as 2:1 for the result of the play to be pass and 1:2 for the result of the play to be run. Then the substitute data module 33340 may extract the user data from the filtered user database 33316. For example, the substitute data module 33340 may extract the filtered user data from the user database 33316. For example, the filtered user data in the user database 33316 may be user data that is like the received wager data from the user prediction module 33326. For example, the wager data from the new entry stored in the odds database 33320 may be the wager ID, such as 201, the event, such as the New England Patriots vs. the New York Jets, the wagering market, such as the result of the play, the wager outcomes, such as the first outcome option being a pass and the second outcome option being a run, the odds for the wager outcomes, such as 2:1 odds for a pass and 1:2 odds for a run. The substitute data module 33340 may not include the event, such as the New England Patriots vs. the New York Jets, to broaden out the filtered data to all the times that a user wagered on a similar wager market, such as the result of a play, with similar wager odds to provide enough data entries to the user prediction module 33326 to perform correlations. In some embodiments, the substitute data module 33340 may determine if there is enough user data in the filtered user database 33316, and if there is not, notify the user prediction module 33326 to exclude the user ID from the process described in the user prediction module 33326. In some embodiments, the substitute data module 33340 may apply various filters to the user data and determine if there is enough user data stored in the filtered user database 33316 and if not, begin to remove filters to achieve the predetermined number of entries, such as 25, to perform the correlations on the user data. For example, the substitute data module 33340 may apply filters to the event, the wagering market, the wager outcomes, the wager odds, etc., and remove the filters one by one until the predetermined threshold is met. The substitute data module 33340 may send the extracted filtered user data from the user database 33316 to the user prediction module 33326. For example, the substitute data module 33340 may extract the user data, such as all the entries that match the wagering market, such as the result of the play, and the wager odds, such as 2:1 for the result of the play to be a pass and 1:2 for the result of the play to be run. Then the substitute module 33340 may end. For example, the substitute data module 33340 may end. In some embodiments, the substitute data module 33340 may be continuously polling to be initiated by the user prediction module 33326, continuously polling to receive data from the user prediction module 33326, etc.

FIG. 334 illustrates the base module 33324. The process may begin with the base module 33324 continuously polling, at step 33400, for a new entry to be stored in the odds database 33320. The base module 33324 may be polling for the odds calculation module 33322 to create and store the new wager data, such as the wager odds, in the odds database 33318. For example, for the event such as the New England Patriots vs. the New York Jets, for the wagering market of the result of the upcoming play, the wager outcomes may be a pass or run with the odds of 2:1 for the result to be a pass and the odds of 1:2 for the result to be a run. Then a new entry may be stored, at step 33402, in the odds database 33320. For example, for the event such as the New England Patriots vs. the New York Jets, for the wagering market of the result of the upcoming play, the wager outcomes may be a pass or run with the odds of 2:1 for the result to be a pass and the odds of 1:2 for the result to be a run. The base module 33324 may extract, at step 33404, the new entry stored in the odds database 33320. For example, the base module 33324 may extract the data such as the New England Patriots vs. the New York Jets, for the wagering market of the result of the upcoming play, the wager outcomes may be a pass or run with the odds of 2:1 for the result to be a pass and the odds of 1:2 for the result to be a run from the odds database 33320. Then the base module 33324 may send, at step 33406, the wager data from the new entry stored in the odds database 33320 to the user prediction module 33326. For example, the base module 33324 may send the extracted wager data from the odds database 33320, such as the New England Patriots vs. the New York Jets, for the wagering market of the result of the upcoming play, the wager outcomes may be a pass or run with the odds of 2:1 for the result to be a pass and the odds of 1:2 for the result to be a run. The user prediction module 33326 may begin with the user prediction module 33326 being initiated by the base module 33324 at step 33408. The user prediction module 33326 may receive the wager data from the new entry stored in the odds database 33320 from the base module 33324. Then the user prediction module 33326 may filter the user database 33316 on the active users. The user prediction module 33326 may filter the user database 33316 on the first user ID currently active on the wagering network 33314. Then the user prediction module 133326 may filter the user database 33316 on the received wager data from the new entry stored in the odds database 33318 from the base module 33324. The user prediction module 33326 may determine if there is enough user data in the filtered user database 33316. If there is enough user data in the filtered user database 33316, then the user prediction module 33326 may extract the user data stored in the user database 33316 that has been filtered by the active users on the wagering network 33314, the user ID, and the received wager data from the new entry stored in the odds database 33318. If there is not enough user data in the filtered user database 33316, then the user prediction module 33326 may initiate the substitute data module 33340. Then the user prediction module 33326 may receive the user data from the substitute data module 33340. The user prediction module 33326 may perform correlations on the extracted data. Then the user prediction module 33326 may determine if the correlations are above a predetermined threshold. If the correlations are above the predetermined threshold, then the user prediction module 33326 may extract the filtered user data. Then the user prediction module 33326 may store the filtered user data in the user bet database 33332. If the correlations are not above the predetermined threshold or after the filtered user data is stored in the user bet database 33332, the user prediction module 33326 may determine if there are more active users remaining on the wagering network 33314. If there are more active users remaining on the wagering network, the user prediction module 33326 may filter the user database 33316 on the next user ID, and the process may return to further filtering the user database 33316 on the received wager data of the new entry stored in the odds database 33318. If there are no more active users remaining on the wagering network 33314, then the user prediction module 33326 may return to the base module 33324. The base module 33324 may initiate, at step 33410, the wager prediction module 33328. For example, the wager prediction module 33328 may begin with the wager prediction module 33328 being initiated by the base module 33324. Then the wager prediction module 33328 may filter the user bet database 33332 on the first user ID. Then the wager prediction module 33328 may determine the probability, likelihood, or percentage that the user will wager on each possible wager outcome. Then the wager prediction module 33328 may select the wager outcome with the highest probability, likelihood, or percentage. Then the wager prediction module 33328 may determine if the probability, likelihood, or percentage exceeds the predetermined threshold. If the probability, likelihood, or percentage exceeds the predetermined threshold, then the wager prediction module 33328 may filter the user bet database 33332 on the wager outcome with the highest probability, likelihood, or percentage. Then the wager prediction module 33328 may determine the average amount wagered by the user on the wager outcome with the highest probability, likelihood, or percentage. The wager prediction module 33328 may store the data in the user prediction database 33334. If the probability, likelihood, or percentage does not exceed the predetermined threshold or after the data is stored in the user prediction database 33334, the wager prediction module 33328 may determine if more users are remaining in the user bet database 33332. If more users are remaining in the user bet database 33332, then the wager prediction module 33328 may filter the user bet database 33332 on the next user ID, and the process may return to determining the probability, likelihood, or percentage that the user will wager for each of the possible wager outcomes. If there are no more users remaining in the user bet database 33332, the wager prediction module 33328 may return to the base module 33324. Then the base module 33324 may initiate, at step 33412, the alter odds module 33330, and the process may return to continuously polling for a new entry to be stored in the odds database 33320. For example, the alter odds module 33330 may begin with the alter odds module 33330 being initiated by the base module 33324. The alter odds module 33330 may filter the user prediction database 33336 on the first wager outcome. Then the alter odds module 33330 may determine how many users will wager on the wager outcome. Then the alter odds module 33330 may determine how much the users will wager on the wager outcome. The alter odds module 33330 may store how many users will wager and how much the users will wager in the wager prediction database 33336. Then the alter odds module 33330 may determine if another wager outcome is stored in the user prediction database 33334. If there is another wager outcome stored in the user prediction database 33334, then the alter odds module 33330 may filter the user prediction database 33334 on the next wager outcome, and the process may return to determine how many users will wager on the wager outcome. If no more wager outcomes are remaining in the user prediction database 33334, then the alter odds module 33330 may determine if there is even action on both sides of the wager. If there is not even action on both sides of the wager, then the alter odds module 33330 may determine the percentages for action for both sides of the wager. Then the alter odds module 33330 may compare the difference in the percentages to the rules database 33338. The alter odds module 33330 may extract the corresponding rule stored in the rules database 33338. Then the alter odds module 33330 may apply the extracted rule to the wager odds for the new entry stored in the odds database 33318. Then the alter odds module 33330 may store the new odds for the wager in the odds database 33318. If there is even action on both sides of the wager or after the new odds are stored in the odds database 33318, then the alter odds module 33330 may offer the wager odds on the wagering app 33310. Then the alter odds module 33330 may return to the base module 33324.

FIG. 335 illustrates the user prediction module 33326. The process may begin with the user prediction module 33326 being initiated, at step 33500, by the base module 33324. The user prediction module 33326 may receive, at step 33502, the wager data from the new entry stored in the odds database 33320 from the base module 33324. For example, the wager data from a new entry stored in the odds database 33320 may be the wager ID, such as 201, the event, such as the New England Patriots vs. the New York Jets, the wagering market, such as the result of the play, the wager outcomes, such as the first outcome option being a pass and the second outcome option being a run, the odds for the wager outcomes, such as 2:1 odds for a pass and 1:2 odds for a run. In some embodiments, the wager data may contain the current time, the time in the event, the players participating in the play, the weather conditions at the event, etc. Then the user prediction module 33326 may filter, at step 33504, the user database 33316 on the active users. For example, the user prediction module 33326 may filter the user database 33316 on all the users that are currently on, are engaged, are signed in, are actively wagering, etc., on the wagering app 33310 through the wagering network 33314. The user prediction module 33326 may filter, at step 33506, the user database 33316 on the first user ID currently active on the wagering network 33314. For example, the user prediction module 33316 further may filter the user database 33316 for the first user ID, such as JS12345, active on the wagering network 33314. Then the user prediction module 33326 may filter, at step 33508, the user database 33316 on the received wager data from the new entry stored in the odds database 33318 from the base module 33324. For example, the user prediction module 33326 may filter the user database 33316 for the active user, such as JS12345, and the received wager data, such as the historical data in which user JS12345 has wagered on the event, such as the New England Patriots vs. the New York Jets, and has wagered on the wagering market, such as the result of the play, with the wager outcomes, such as pass and run, containing the same odds, such as 2:1 odds for a pass and 1:2 odds for a run. The user prediction module 33326 may determine, at step 33510, if enough user data is in the filtered user database 33316. For example, there may be a predetermined threshold for the number of entries stored in the filtered user database 33316 to perform correlations on the user's data, such as 25 entries. If there is enough user data in the filtered user database 33316, then the user prediction module 33326 may extract, at step 33512, the user data stored in the user database 33316 that has been filtered by the active users on the wagering network 33314, the user ID, and the received wager data from the new entry stored in the odds database 33318. For example, the data that is extracted is the historical data in which the active user has wagered on the event, such as the New England Patriots vs. the New York Jets, and has wagered on the wagering market, such as the result of the play, with the wager outcomes, such as pass and run, containing the same odds, such as 2:1 odds for a pass and 1:2 odds for a run. If there is not enough user data in the filtered user database 33316, then the user prediction module 33326 may initiate, at step 33514, the substitute data module 33340. For example, if the number of entries stored in the filtered user database 33316 does not exceed the predetermined threshold, such as 25 entries, then the user prediction module 33326 may initiate the substitute data module 33340. For example, the substitute data module 33340 may begin with the substitute data module 33340 initiated by the user prediction module 33326. For example, If there is not enough user data in the filtered user database 33316, then the user prediction module 33326 may initiate the substitute data module 33340, which may filter the user database 33316 to provide enough user data, for example, over 25 entries, to the user prediction module 33326 to perform correlations on the user data. In some embodiments, the user prediction module 33326 may send the user ID and the received wager data to the substitute data module 33340. Then the substitute data module 33340 may filter the user database 33316 on the user ID. For example, the substitute data module 33340 may filter the user database on user ID JS12345. The substitute data module 33340 may filter the user database 33316 on the wagering market. For example, the substitute data module 33340 may filter the user database 33316 on the user ID and the received wager market from the wager data received from the user prediction module 33326, such as the result of a play. Then the substitute data module 33340 may filter the user database 33316 on the wager odds. For example, the substitute data module 33340 may filter the user database 33316 on the user ID, the wagering market, and the received wager odds from the user prediction module 33326, such as 2:1 for the result of the play to be pass and 1:2 for the result of the play to be run. Then the substitute data module 33340 may extract the user data from the filtered user database 33316. For example, the substitute data module 33340 may extract the filtered user data from the user database 33316. For example, the filtered user data in the user database 33316 is user data that is like the received wager data from the user prediction module 33326. For example, the wager data from the new entry stored in the odds database 33320 may be the wager ID, such as 201, the event, such as the New England Patriots vs. the New York Jets, the wagering market, such as the result of the play, the wager outcomes, such as the first outcome option being a pass and the second outcome option being a run, the odds for the wager outcomes, such as 2:1 odds for a pass and 1:2 odds for a run. The substitute data module 33340 may not include the event, such as the New England Patriots vs. the New York Jets, to broaden out the filtered data to all the times that a user wagered on a similar wager market, such as the result of a play, with similar wager odds to provide enough data entries to the user prediction module 33326 to perform correlations. In some embodiments, the substitute data module 33340 may determine if there is enough user data in the filtered user database 33316, and if there is not, notify the user prediction module 33326 to exclude the user ID from the process described in the user prediction module 33326. In some embodiments, the substitute data module 33340 may apply various filters to the user data and determine if there is enough user data stored in the filtered user database 33316 and if not, begin to remove filters to achieve the predetermined number of entries, such as 25, to perform the correlations on the user data. For example, the substitute data module 33340 may apply filters to the event, the wagering market, the wager outcomes, the wager odds, etc., and remove the filters one by one until the predetermined threshold is met. The substitute data module 33340 may send the extracted filtered user data from the user database 33316 to the user prediction module 33326. For example, the substitute data module 33340 may extract the user data, such as all the entries that match the wagering market, such as the result of the play, and the wager odds, such as 2:1 for the result of the play to be a pass and 1:2 for the result of the play to be run. Then the substitute module 33340 may end. For example, the substitute data module 33340 may end. In some embodiments, the substitute data module 33340 may be continuously polling to be initiated by the user prediction module 33326, continuously polling to receive data from the user prediction module 33326, etc. Then the user prediction module 33326 may receive, at step 33516, the user data from the substitute data module 33340. For example, the user prediction module 33326 may receive the user data from substitute data module 33340. For example, the user prediction module 33326 may receive the user data, such as all the entries that match the wagering market, such as the result of the play, and the wager odds, such as 2:1 for the result of the play to be a pass and 1:2 for the result of the play to be run. The user prediction module 33326 may perform, at step 33518, correlations on the extracted data. For example, the extracted data is for the historical instances in which the active user wagered matching the received wager data, such as the event, wager market, wager outcomes, and wager odds, and then correlations may be performed on the number of the wager confirmed by the user, such as the user's first wager, second wager, third wager, etc. and the total amount wagered by the user in that situation. An example of correlated parameters is with the number of wagers vs. total amount wagered with a 0.97 correlation coefficient, and the filtered user data is extracted and stored in the user bet database 33332, for example, the number of the wager, such as first, second, third, etc., the total amount wagered, the wager outcome that the user wagered on in that instance, such as pass or run, and the wagered amount for each wager, such as $10. Then the user prediction module 33326 may determine, at step 33520, if the correlations are above a predetermined threshold. For example, the predetermined threshold may be set at a 0.90 correlation coefficient to determine if the user's data is highly correlated enough to predict that the user has consistently wagered on the wagering market, allowing the user prediction module 33326 to determine that the user's data is relevant for predicting the upcoming action on the new wager data entry stored in odds database 33320 to ensure that the wagering network 33314 provides wager odds to allow for an even 50/50 split of money from users being wagered on both sides of the wager. If the correlations are above the predetermined threshold, then the user prediction module 33326 may extract, at step 33522, the filtered user data. For example, if the correlation coefficient is above 0.90, such as a correlation coefficient of 0.97, then the filtered user data is extracted; for example, the data may be the number of the wager, such as first, second, third, etc., the total amount wagered, the wager outcome that the user wagered on in that instance, such as pass or run, and the wagered amount for each wager, such as $10. Then the user prediction module 33326 may store, at step 33524, the filtered user data in the user bet database 33332. For example, the user prediction module 33326 may store the filtered user data, such as the number of the wager, such as first, second, third, etc., the total amount wagered, the wager outcome that the user wagered on in that instance, such as pass or run, and the wagered amount for each wager, such as $10. If the correlations are not above the predetermined threshold or after the filtered user data is stored in the user bet database 33332, the user prediction module 33326 may determine, at step 33526, if there are more active users remaining on the wagering network 33314. If the correlation coefficient does not exceed the predetermined threshold, such as 0.90 correlation coefficient, the user prediction module 33326 may determine that the user has not consistently wagered on the wagering market with the specific wager odds, and thus the user's data would not be relevant to predict the upcoming action for the new wager data stored in the odds database 33320. If there are more active users remaining on the wagering network, the user prediction module 33326 may filter, at step 33528, the user database 33316 on the next user ID, and the process may return to further filtering the user database 33316 on the received wager data of the new entry stored in the odds database 33318. For example, the user prediction module 33326 would filter the user database 33316 on the next active user, such as TR98765, and the process would filter the user database 33316 on the received wager data from the new entry to perform the correlations on the next user's data. If there are no more active users remaining on the wagering network 33314, then the user prediction module 33326 may return, at step 33530, to the base module 33324.

FIG. 336 illustrates the wager prediction module 33328. The process may begin with the wager prediction module 33328 being initiated, at step 33600, by the base module 33324. Then the wager prediction module 33328 may filter, at step 33602, the user bet database 33332 on the first user ID. For example, the wager prediction module 33328 may filter the user bet database 33332 on the user ID JS12345. Then the wager prediction module 33328 may determine, at step 33604, the percentage that the user will wager on each possible wager outcome. For example, if the wager outcomes are either pass or run, the wager prediction module 33328 may determine the percentage chance that the user will wager on a pass and the percentage chance that the user will wager on a run using the user's historical data stored in the user bet database 33332. For example, if the user has completed five total wagers for the specific wager market and has wagered three times on pass and two times on a run, the percentages may be 60% for a pass and 40%. Then the wager prediction module 33328 may select, at step 33606, the wager outcome with the highest percentage. For example, if the user has a 60% chance of wagering on a pass and a 40% chance of wagering on a run, then the pass wager outcome may be selected. Then the wager prediction module 33328 may determine, at step 33608, if the percentage exceeds the predetermined threshold. For example, there may be a predetermined threshold, such as 55%, to determine if the user consistently wagers on a specific wager outcome, such as pass. If the percentage is below the predetermined threshold, it may be determined that the user consistently wagers on both sides of the wager outcomes and thus cannot be used for prediction purposes. If the percentage exceeds the predetermined threshold, then the wager prediction module 33328 may filter, at step 33610, the user bet database 33332 on the wager outcome with the highest percentage. For example, if the selected wager outcome were a pass, then the user bet database 33332 may be filtered on the user ID, such as JS12345, and the wager outcome, such as pass. Then the wager prediction module 33328 may determine, at step 33612, the average amount wagered by the user on the wager outcome with the highest percentage. For example, the wager prediction module 33328 may count the number of times the user wagered on the outcome, such as three, and the total amount wagered by the user. For example, if the user wagered $10 on every wager, their total wagered amount may be $30 and the wager prediction module 33328 would divide the three times wagered by the $30 wagered total to determine the average wager amount of $10. The wager prediction module 128 may store, at step 33614, the data in the user prediction database 33334. For example, the wager prediction module 33328 would store the user ID, such as JS12345, the wager outcome or wager result, such as pass, and the average amount wagered, such as $10, in the user prediction database 33334. If the percentage does not exceed the predetermined threshold or after the data is stored in the user prediction database 33334, the wager prediction module 33328 may determine, at step 33616, if more users are remaining in the user bet database 33332. For example, if the percentage is below the predetermined threshold, it may be determined that the user consistently wagers on both sides of the wager outcomes and thus cannot be used for prediction purposes. If more users are remaining in the user bet database 33332, then the wager prediction module 33328 may filter, at step 33618, the user bet database 33332 on the next user ID, and the process may return to determining the percentage that the user will wager for each of the possible wager outcomes. If there are no more users remaining in the user bet database 33332, the wager prediction module 33328 may return, at step 33620, to the base module 33324.

FIG. 337 illustrates the alter odds module 33330. The process may begin with the alter odds module 33330 being initiated, at step 33700, by the base module 33324. The alter odds module 33330 may filter, at step 33702, the user prediction database 33334 on the first wager outcome. For example, the alter odds module 33330 may filter the user prediction database 33334 on the first wager outcome or wager result, such as pass. Then the alter odds module 33330 may determine, at step 33704, how many users will wager on the wager outcome. For example, the alter odds module 33330 may count how many users are in the filtered user prediction database 33334 to determine how many users will wager on a pass. Then the alter odds module 33330 may determine, at step 33706, how much the users will wager on the wager outcome. For example, the alter odds module 33330 may count the average wager amount for each user to determine the total amount that will be wagered on the wager outcome being a pass. The alter odds module 33330 may store, at step 337508, how many users will wager and how much the users will wager in the wager prediction database 33336. For example, the alter odds module may store the number of users, such as three, the amount that will be wagered by those users, such as $30, in the wager prediction database 33336. Then the alter odds module 33330 may determine, at step 33710, if another wager outcome is stored in the user prediction database 33334. For example, if there is another wager outcome, such as run, then the alter odds module 33330 will filter the user prediction database 33334 on the wager outcome being a run. If there is another wager outcome stored in the user prediction database 33334, then the alter odds module 33330 may filter, at step 33712, the user prediction database 33334 on the next wager outcome, and the process may return to determine how many users will wager on the wager outcome. If no more wager outcomes are remaining in the user prediction database 33334, then the alter odds module 33330 may determine, at step 33714, if there is even action on both sides of the wager. For example, if there is a prediction that there will be $30 on the wager outcome being a pass and $20 on the wager outcome being a run, there would not be even action on the wager. If there is not even action on both sides of the wager, then the alter odds module 33330 may determine, at step 33716, the percentages for action for both sides of the wager. For example, if there is a prediction that there will be $30 on the wager outcome being a pass and $20 on the wager outcome being a run, then that may be 60% of the money on a pass and only 40% of the money being wagered on a run, which for the pass outcome may be above 20% and for the run outcome that may be below 20%. Then the alter odds module 33330 may compare, at step 33718, the difference in the percentages to the rules database 33338. For example, the alter odds module 33330 may compare the above 20% for the outcome being a pass and below 20% for the outcome being a run to the rules database 138. For example, if there are two possible wager outcomes, such as pass and run, and there is 60% of the money on the pass wagers and only 40% of the money on run wagers, there is not even action on both sides of the wager, an ideal percentage may be 50% of wagers or money on one side and 50% of wagers or money on the other side. So, the difference in percentages may be 20%, so the 2:1 odds for a pass may be above 20%, and the corresponding rule may be to decrease the odds by 20% so that the 2:1 odds for a pass would drop to 1.6:1 odds for the outcome to be a pass. The difference may be under 20% for the run wager, and the odds for a run may be altered from 1:2 odds to 1:1.6 odds since the corresponding rule may be to increase the odds by 20%. The alter odds module 33330 may extract, at step 33720, the corresponding rule stored in the rules database 33338. For example, the extracted rule may be that the wager odds for the wager outcome being a pass would decrease the odds by 20%, and the wager odds for the wager outcome being a run may be to increase the odds by 20%. Then the alter odds module 33330 may apply, at step 33722, the extracted rule to the wager odds for the new entry stored in the odds database 33318. For example, the original 2:1 odds for a pass would decrease by 20% to 1.6:1 odds for the outcome to be a pass, and the original 1:2 odds for a run would increase by 20% to 1:1.6 odds for the outcome to be run. Then the alter odds module 33330 may store, at step 33724, the new odds for the wager in the odds database 33318. For example, the alter odds module 33330 would store the wager odds of the 1.6:1 for a pass and 1:1.6 for a run in the odds database 33320, updating the wager data stored for the new entry. If there is even action on both sides of the wager or after the new odds are stored in the odds database 33318, then the alter odds module 33330 may offer, at step 33726, the wager odds on the wagering app 33310. Then the alter odds module 33330 may return, at step 33728, to the base module 33324.

FIG. 338 illustrates the user bet database 33332. The user bet database 33332 may contain the wager ID, the event, the wagering market, the possible outcomes for the wager, the odds for the wager, the user ID, the number of the wager in sequential order, the total amount wagered, the outcome wagered on, and the amount wagered for the wager. For example, the user bet database 33332 may store the wager data from the odds database 33320 such as the wager ID, such as 201, the event, such as the New England Patriots vs. the New York Jets, the outcomes for the wager, such as the first outcome being a pass and the second outcome being a run, and the odds for the possible outcomes, such as the odds of 2:1 for the outcome to be a pass and the odds 1:2 for the outcome to be a run. For example, the user bet database 132 may store the filtered user data from the user database 33316 as described in the user prediction module 33326, which may contain the user ID, such as JS12345, the number of the wager in sequential order, such the users first wager, second wager, third wager, etc., the total amount wagered up to that point in time, such as $10 wagered total, $20 wagered total, etc., the outcome that the user wagered on, such as pass or run, and the amount that the user wagered on that individual wager, such as $10. In some embodiments, the user bet database 33332 may contain the correlation coefficients calculated during the user prediction module 33326. In some embodiments, the user bet database 33332 may contain the predetermined threshold of the correlation coefficient to determine if the data should be stored in the database or not.

FIG. 339 illustrates the user prediction database 33334. The user prediction database 33334 may contain the user ID, the wager result, and the average amount wagered and may be created during the process described in the wager prediction module 33328 and may be used in the process described in the alter odds module 33330. For example, the user prediction database 33334 may contain the user ID, such as JS12345, the wager result, such as pass, and the average amount wagered by the user, such as $10.

FIG. 340 illustrates the wager prediction database 33336. The wager prediction database 33336 may be created in the process described in the alter odds module 33330 and may contain the wager outcome, such as pass, the number of users that will wager on that outcome, such as three users will wager on a pass, and the amount wagered on the outcome, such as there will be $30 wagered on a pass. In addition, in some embodiments, there may be additional wager outcomes in which the process described in the alter odds module 33330 will determine, for each possible wager outcome, the number of users that will wager on the wager outcome and the amount that will be wagered on the wager outcome.

FIG. 341 illustrates the rules database 33338. The rules database 33338 may contain the difference in percentages between the possible wager outcomes and the rule which should be applied to the wagering odds. For example, if there are two possible wager outcomes, such as pass and run, and there is 60% of the money on the pass wagers and only 40% of the money on run wagers, there is not even action on both sides of the wager, an ideal percentage may be 50% of wagers or money on one side and 50% of wagers or money on the other side. So, the difference in percentages may be 20%, so the 2:1 odds for a pass may be above 20%, and the corresponding rule may be to decrease the odds by 20% so that the 2:1 odds for a pass would drop to 1.6:1 odds for the outcome to be a pass. The difference may be under 20% for the run wager, and the odds for a run may be altered from 1:2 odds to 1:1.6 odds since the corresponding rule may be to increase the odds by 20%.

FIG. 342 illustrates the substitute data module 33340. The process may begin with the substitute data module 33340 being initiated, at step 342000, by the user prediction module 33326. For example, If there is not enough user data in the filtered user database 33316, then the user prediction module 33326 may initiate the substitute data module 33340, which may filter the user database 33316 to provide enough user data, for example, over 25 entries, to the user prediction module 33326 to perform correlations on the user data. In some embodiments, the user prediction module 33326 may send the user ID and the received wager data to the substitute data module 33340. Then the substitute data module 33340 may filter, at step 342002, the user database 33316 on the user ID. For example, the substitute data module 33340 may filter the user database on user ID JS12345. The substitute data module 33340 may filter, at step 342004, the user database 33316 on the wagering market. For example, the substitute data module 33340 may filter the user database 33316 on the user ID and the received wager market from the wager data received from the user prediction module 33326, such as the result of a play. Then the substitute data module 33340 may filter, at step 342006, the user database 33316 on the wager odds. For example, the substitute data module 33340 may filter the user database 33316 on the user ID, the wagering market, and the received wager odds from the user prediction module 33326, such as 2:1 for the result of the play to be pass and 1:2 for the result of the play to be run. Then the substitute data module 140 may extract, at step 342008, the user data from the filtered user database 33316. For example, the substitute data module 33340 may extract the filtered user data from the user database 33316. For example, the filtered user data in the user database 33316 may be user data that is like the received wager data from the user prediction module 33326. For example, the wager data from the new entry stored in the odds database 33320 may be the wager ID, such as 201, the event, such as the New England Patriots vs. the New York Jets, the wagering market, such as the result of the play, the wager outcomes, such as the first outcome option being a pass and the second outcome option being a run, the odds for the wager outcomes, such as 2:1 odds for a pass and 1:2 odds for a run. The substitute data module 33340 may not include the event, such as the New England Patriots vs. the New York Jets, to broaden out the filtered data to all the times that a user wagered on a similar wager market, such as the result of a play, with similar wager odds to provide enough data entries to the user prediction module 33326 to perform correlations. In some embodiments, the substitute data module 33340 may determine if there is enough user data in the filtered user database 33316, and if there is not, notify the user prediction module 33326 to exclude the user ID from the process described in the user prediction module 33326. In some embodiments, the substitute data module 33340 may apply various filters to the user data and determine if there is enough user data stored in the filtered user database 33316 and if not, begin to remove filters to achieve the predetermined number of entries, such as 25, to perform the correlations on the user data. For example, the substitute data module 33340 may apply filters to the event, the wagering market, the wager outcomes, the wager odds, etc., and remove the filters one by one until the predetermined threshold is met. The substitute data module 33340 may send, at step 342010, the extracted filtered user data from the user database 33316 to the user prediction module 33326. For example, the substitute data module 33340 may extract the user data, such as all the entries that match the wagering market, such as the result of the play, and the wager odds, such as 2:1 for the result of the play to be a pass and 1:2 for the result of the play to be run. Then the substitute module 33340 may end at step 342012. For example, the substitute data module 33340 may end. In some embodiments, the substitute data module 33340 may be continuously polling to be initiated by the user prediction module 33326, continuously polling to receive data from the user prediction module 33326, etc.

FIG. 343 illustrates a system for creating new wagers and optimize odds in an online play-by-play sports betting game, according to an embodiment.

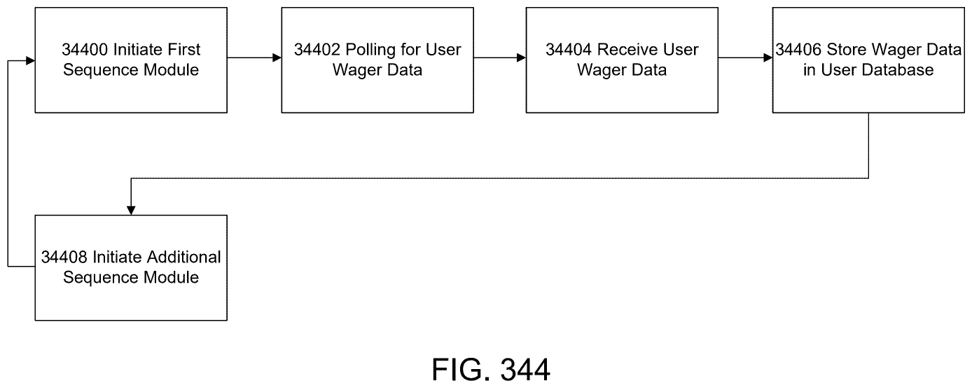

FIG. 344 illustrates a base module, according to an embodiment.

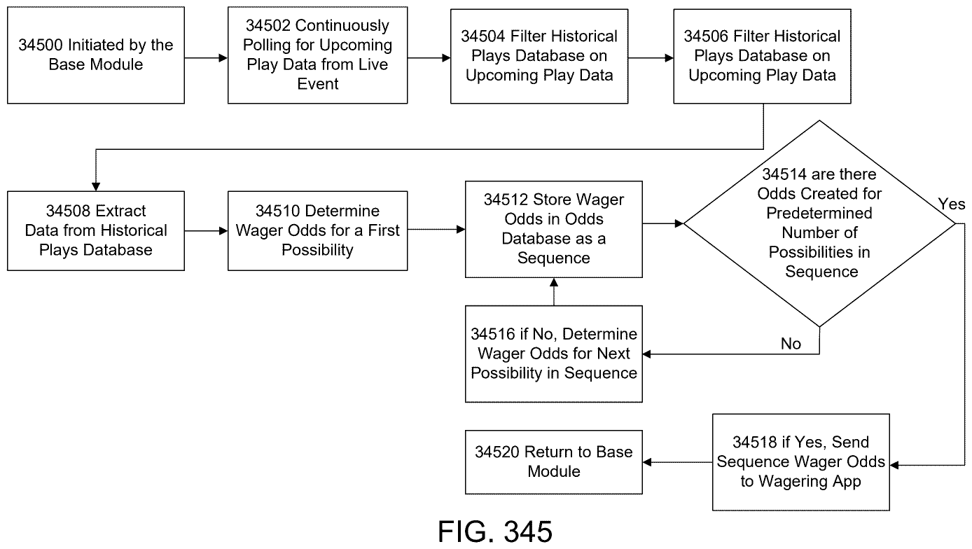

FIG. 345 illustrates a first sequence module, according to an embodiment.

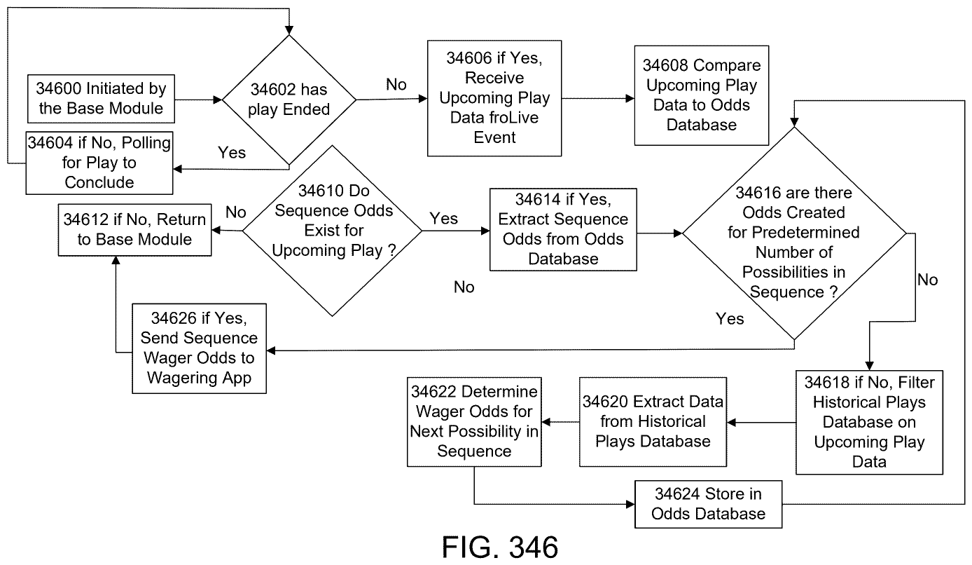

FIG. 346 illustrates an additional sequence module, according to an embodiment.

FIG. 343 is a system for creating new wagers and optimize odds in an online play-by-play sports betting game. This system may include a live event 34302, for example, a sporting event such as a football, basketball, baseball, or hockey game, tennis match, golf tournament, eSports, or digital game, etc. The live event 34302 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team may need to cover if the result of the game with the same as the point spread the user may not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 34302, such as the score of an American football game or the run line in a baseball game, or a series of actions in the live event 34302. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 34302 or at another location.

Further, embodiments may include a plurality of sensors 34304 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 34304 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 34306 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 34306 may be communicatively coupled to a peer-to-peer wagering network 34314, which may perform real-time analysis on the type of play and the result of the play. The cloud 34306 may also be synchronized with game situational data such as the time of the game, the score, location on the field, weather conditions, and the like, which may affect the choice of play utilized. For example, in an exemplary embodiment, the cloud 34306 may not receive data gathered from the sensors 34304 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 34308 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 34308 could be an optional component and may be utilized in a situation where a paired wearable device employs the mobile device 34308 for additional memory or computing power or connection to the internet.

Further, embodiments may include a wagering software application or a wagering app 34310, which is a program that enables the user to place bets on individual plays in the live event 102, streams audio and video from the live event 34302, and features the available wagers from the live event 34302 on the mobile device 34308. The wagering app 34310 allows the user to interact with the wagering network 34314 to place bets and provide payment/receive funds based on wager outcomes.

Further, embodiments may include a mobile device database 34312 that may store some or all the user's data, the live event 34302, or the user's interaction with the wagering network 34314.

Further, embodiments may include the wagering network 34314, which may perform real-time analysis on the type of play and the result of a play or action. The wagering network 34314 (or the cloud 34306) may also be synchronized with game situational data, such as the time of the game, the score, location on the field, weather conditions, and the like, which may affect the choice of play utilized. For example, in an exemplary embodiment, the wagering network 34314 may not receive data gathered from the sensors 34304 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 34314 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 34316, which may contain data relevant to all users of the wagering network 34314 and may include, but is not limited to, a user ID, a device identifier, a paired device identifier, wagering history, or wallet information for the user. The user database 34316 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 34316 may contain betting lines and search queries. The user database 34316 may be searched based on a search criterion received from the user. Each betting line may include but is not limited to, a plurality of betting attributes such as at least one of the following: the live event 34302, a team, a player, an amount of wager, etc. The user database 34316 may include, but is not limited to, information related to all the users involved in the live event 34302. In one exemplary embodiment, the user database 116 may include information for generating a user authenticity report and a wagering verification report. Further, the user database 34316 may be used to store user statistics like, but not limited to, the retention period for a particular user, frequency of wagers placed by a particular user, the average amount of wager placed by each user, etc.

Further, embodiments may include a historical plays database 34318 that may contain play data for the type of sport being played in the live event 34302. For example, in American Football, for optimal odds calculation, the historical play data may include metadata about the historical plays, such as time, location, weather, previous plays, opponent, physiological data, etc.

Further, embodiments may utilize an odds database 34320—that may contain the odds calculated by an odds calculation module 34322—to display the odds on the user's mobile device 34308 and take bets from the user through the mobile device wagering app 34310.

Further, embodiments may include the odds calculation module 34322, which may utilize historical play data to calculate odds for in-play wagers.

Further, embodiments may include a base module 34324, which may begin with the base module 34324 initiating the first sequence module 34326. Then the base module 34324 may continuously poll for the user's wager data. For example, the user may wager on the number of pitches during the at-bat for J. D. Martinez during the 5th inning of the Boston Red Sox vs. the New York Yankees event. Then the base module 34324 may receive the user's wager data. For example, the user may wager on the number of pitches during the at-bat for J. D. Martinez during the 5th inning of the Boston Red Sox vs. the New York Yankees event. The base module 34324 may store the user's wager data in the user database 34316. The user's wager data may be information about the wager and the relevant results in the live event 34302. For example, the at-bat may last only one pitch, the wager odds, such as 20:1, the amount wagered, such as $20, and the user's information, such as user ID, address, e-mail, etc. Then the base module 34324 may initiate the additional sequence module 34328, and the process may return to initiating the first sequence module 34326.

Further, embodiments may include a first sequence module 34326, which may begin with the base module 34324 initiating the first sequence module 34326. The first sequence module 34326, may continuously poll for the upcoming play data from the live event 34302. For example, the first sequence module 34326 may continuously poll to receive the data from the live event 34302 that represents the current state of the live event 34302, such as in the Boston Red Sox vs. New York Yankees game it is the top of the 5th inning, with one out and J. D. Martinez at-bat with no pitches being thrown yet. Then the first sequence module 34326, may receive the upcoming play data from the live event 34302. For example, the upcoming play data may be in the Boston Red Sox vs. New York Yankees game; it is the top of the 5th inning, with one out and J. D. Martinez at-bat with no pitches thrown yet. The first sequence module 34326, may filter the historical plays database 34318 on the upcoming play data. For example, the historical plays database 34318 is filtered for the Boston Red Sox vs. the New York Yankees, in top of the 5th inning, with one out and the batter being J. D. Martinez. Then the first sequence module 34326, may extract the data from the historical plays database 34318. For example, the first sequence module 34326 may extract all the historical wagering odds data associated with the event being the Boston Red Sox vs. New York Yankees game in the top of the 5th inning, with one out and J. D. Martinez at-bat with no pitches being thrown yet. The first sequence module 34326, may determine the wager odds. For example, the first sequence module 34326 may determine the average wager odds from the odds of the historical wager extracted from the historical plays database 34318, such as the number of times or occasions that the Boston Red Sox's J. D. Martinez at-bat lasted only one pitch versus the New York Yankees. For example, if J. D. Martinez has 100 at-bats versus the New York Yankees and out of those 100 at-bats only five times did the at-bat last only one pitch, then there may only be a 5% chance for the at-bat to be a one-pitch at-bat, which the odds may be 100:5 or displayed to the user as 20:1 odds for the at-bat to be a one-pitch at-bat. Then the first sequence module 34326, may store the wager odds in the odds database 34322 as a sequence. Wherein the wager odds sequence may be a series of wager odds possibilities for a play based on the play data and historical play data. For example, the wager odds 20:1 are stored in the odds database 34322 for the Boston Red Sox's J. D. Martinez at-bat lasted only one pitch versus the New York Yankees. Then the first sequence module 34326, may determine if there are odds created for a predetermined number of possibilities in the sequence. For example, there may need to be other odds calculated for the number of pitches thrown during the Boston Red Sox's J. D. Martinez at-bat versus the New York Yankees, such as two pitches, three pitches, four pitches, etc. and the predetermined number of possibilities may be set at seven or another number set by an administrator. For example, for every at-bat, the wagering network offers users odds for the number of pitches that may occur during an at-bat, with each pitch having different odds, such as the at-bat lasting one pitch at 20:1 odds. In some embodiments, the sequence odds may be determined differently for different sports. For example, in baseball, the sequence odds may be for pitches during an at-bat; for football, it may be the number of plays during an offensive drive; for basketball, it may be the number of consecutive missed baskets or made baskets; for hockey, it may be the number of consecutive shots for the home or away team, etc. If there are not enough odds created for the predetermined number of possibilities in the sequence, then the first sequence module 34326, may determine the wager odds for the next possibility, and the process may return to storing the wager odds in the odds database 34322. For example, in the odds database 34322, the odds for the at-bat to last one pitch is already stored, so the next possibility may be for the at-bat to last two pitches. For example, if J. D. Martinez has 100 at-bats versus the New York Yankees and out of those 100 at-bats only ten times did the at-bat last two pitches, then there may only be a 10% chance for the at-bat to be a two-pitch at-bat, which the odds may be 100:10 or displayed to the user as 10:1 odds for the at-bat to be a two-pitch at-bat. Since the predetermined number of possibilities is set at seven, then the first sequence module 34326, may repeat this loop until the odds are calculated for the at-bat to last one pitch, two pitches, three pitches, four pitches, five pitches, six pitches, and seven pitches. In some embodiments, the predetermined number of possibilities may be set at any number, and seven is only used as an example. If there are enough odds created for the predetermined number of possibilities in the sequence, then the first sequence module 34326 may send the sequence wager odds to the wagering app 34310. For example, the sequence odds sent to the wagering app 34310 may mean that the Boston Red Sox's J. D. Martinez at-bat may last one pitch, at 20:1 odds, two pitches, at 10:1 odds, three pitches, at 5:1 odds, etc. Then the first sequence module 34326, may return to the base module 34324.

Further, embodiments may include an additional sequence module 34328, which may begin with the additional sequence module 34328 being initiated by the base module 34324. The additional sequence module 34328 may determine if the previous play has ended. For example, the additional sequence module 34328 may determine if the data has been received from the live event 34302 for the results of the play in the Boston Red Sox vs. New York Yankees game in the top of the 5th inning, with one out and J. D. Martinez at-bat with no pitches being thrown yet. If the previous play has not ended, then the additional sequence module 34328 may continuously poll for the play to conclude. For example, the additional sequence module 34328 may continuously poll to receive the data from the live event 34302 for the results of the play in the Boston Red Sox vs. New York Yankees game in the top of the 5th inning, with one out and J. D. Martinez at-bat with no pitches being thrown yet. If the previous play has concluded, then the additional sequence module 34328 may receive the upcoming play data from the live event 34302. For example, the additional sequence module 34328 may receive from the live event 34302 for the results of the play in the Boston Red Sox vs. New York Yankees game in the top of the 5th inning, with one out and J. D. Martinez at-bat with one pitch being thrown. Then the additional sequence module 34328 may compare the upcoming play data to the odds database 34322. For example, the additional sequence module 34328 may compare the date of the event, the time of the event, the teams playing, the time within the event, and the players in the event to determine if there are current sequence odds available. For example, if the date is Jul. 8, 2021, the time of the event is 8:15 pm EST, the teams playing are the Boston Red Sox vs. the New York Yankees, the time within the event is the 5th inning, and the batter is J. D. Martinez then the odds database 34322 may contain the record of sequence odds created during the process described in the first sequence module 34326. The additional sequence module 34328 may determine if there is an existing sequence for the upcoming play. For example, the additional sequence module 34328 may compare the date of the event, the time of the event, the teams playing, the time within the event, and the players in the event to determine if there are current sequence odds available. For example, if the date is Jul. 8, 2021, the time of the event is 8:15 pm EST, the teams playing are the Boston Red Sox vs. the New York Yankees, the time within the event is the 5th inning, and the batter is J. D. Martinez then the odds database 34322 may contain the record of sequence odds created during the process described in the first sequence module 34326. If there is no sequence available in the odds database 34322, then the additional sequence module 34328 may return to the base module 34324. For example, the additional sequence module 34328 may return to the base module 34324 to create the first sequence odds. If there is a sequence available in the odds database 34322, then the additional sequence module 34328 may extract the sequence odds from the odds database 34322. For example, the data extracted may be the date is Jul. 8, 2021, the time of the event is 8:15 pm EST, the teams playing are the Boston Red Sox vs. the New York Yankees, the time within the event is the 5th inning, and the batter is J. D. Martinez, with the sequence odds of the at-bat may last one pitch, at 20:1 odds, two pitches, at 10:1 odds, three pitches, at 5:1 odds, etc. Then the additional sequence module 34328 may determine if there are odds created for the predetermined number of possibilities in the sequence. For example, the first pitch has occurred so the odds of 20:1 for the at-bat to last one pitch may no longer be available to the user and thus removed from the sequence, this may result in the sequence only containing six possibilities, and that may not meet the predetermined threshold of seven possibilities and the corresponding odds. If there are not enough odds created for the predetermined number of possibilities in the sequence, then the additional sequence module 34328 may filter the historical plays database 34318 on the upcoming play data. For example, the historical plays database 34318 is filtered for the Boston Red Sox vs. the New York Yankees, in top of the 5th inning, with one out and the batter being J. D. Martinez. Then the additional sequence module 34328 may extract the data from the historical plays database 34318. For example, the first sequence module 34326 may extract all the historical wagering odds data associated with the event being the Boston Red Sox vs. New York Yankees game in the top of the 5th inning, with one out and J. D. Martinez at-bat with one pitch being thrown. The additional sequence module 34328 may determine the wager odds for the next possibility in the sequence. For example, the sequence odds for the at-bat to last two pitches through seven pitches may be stored in the odds database, so the additional sequence module may need to calculate the odds for the at-bat to last eight pitches. For example, if J. D. Martinez has 100 at-bats versus the New York Yankees and out of those 100 at-bats only 20 times did the at-bat last only eight pitches, then there may only be a 20% chance for the at-bat to last eight pitches, which the odds may be 100:20 or displayed to the user as 5:1 odds for the at-bat to last eight pitches. Then the additional sequence module 34328 may store the wager odds in the odds database 34322. For example, the 5:1 odds for the at-bat to last eight pitches may be stored with the current sequence odds in the odds database 34322. If there are enough odds created for the predetermined number of possibilities in the sequence, then the additional sequence module 34328 may send the sequence wager odds to the wagering app 34310, and the process may return to the additional sequence module 34328 returning to the base module 34324. For example, the sequence odds sent to the wagering app 34310 may mean that the Boston Red Sox's J. D. Martinez at-bat may be two pitches, at 10:1 odds, three pitches, at 5:1 odds, or up to the eight pitches, at 5:1 odds.

FIG. 344 illustrates the base module 34324. The process may begin with the base module 34324 initiating, at step 34400, the first sequence module 34326. For example, the first sequence module 34326 may begin with the base module 34324 initiating the first sequence module 34326. The first sequence module 34326, may continuously poll for the upcoming play data from the live event 34302. For example, the first sequence module 34326 may continuously poll to receive the data from the live event 34302 that represents the current state of the live event 34302, such as in the Boston Red Sox vs. New York Yankees game it is the top of the 5th inning, with one out and J. D. Martinez at-bat with no pitches being thrown yet. Then the first sequence module 34326, may receive the upcoming play data from the live event 34302. For example, the upcoming play data may be in the Boston Red Sox vs. New York Yankees game; it is the top of the 5th inning, with one out and J. D. Martinez at-bat with no pitches thrown yet. The first sequence module 34326, may filter the historical plays database 34318 on the upcoming play data. For example, the historical plays database 34318 is filtered for the Boston Red Sox vs. the New York Yankees, in top of the 5th inning, with one out and the batter being J. D. Martinez. Then the first sequence module 34326, may extract the data from the historical plays database 34318. For example, the first sequence module 34326 may extract all the historical wagering odds data associated with the event being the Boston Red Sox vs. New York Yankees game in the top of the 5th inning, with one out and J. D. Martinez at-bat with no pitches being thrown yet. The first sequence module 34326, may determine the wager odds. For example, the first sequence module 34326 may determine the average wager odds from the odds of the historical wager extracted from the historical plays database 34318, such as the number of times or occasions that the Boston Red Sox's J. D. Martinez at-bat lasted only one pitch versus the New York Yankees. For example, if J. D. Martinez has 100 at-bats versus the New York Yankees and out of those 100 at-bats only five times did the at-bat last only one pitch, then there may only be a 5% chance for the at-bat to be a one-pitch at-bat, which the odds may be 100:5 or displayed to the user as 20:1 odds for the at-bat to be a one-pitch at-bat. Then the first sequence module 34326, may store the wager odds in the odds database 34322 as a sequence. Wherein the wager odds sequence may be a series of wager odds possibilities for a play based on the play data and historical play data. For example, the wager odds 20:1 are stored in the odds database 34322 for the Boston Red Sox's J. D. Martinez at-bat lasted only one pitch versus the New York Yankees. Then the first sequence module 34326, may determine if there are odds created for a predetermined number of possibilities in the sequence. For example, there may need to be other odds calculated for the number of pitches thrown during the Boston Red Sox's J. D. Martinez at-bat versus the New York Yankees, such as two pitches, three pitches, four pitches, etc. and the predetermined number of possibilities may be set at seven. For example, for every at-bat, the wagering network offers users odds for the number of pitches that may occur during an at-bat, with each pitch having different odds, such as the at-bat lasting one pitch at 20:1 odds. In some embodiments, the sequence odds may be determined differently for different sports. For example, in baseball, the sequence odds may be for pitches during an at-bat; for football, it may be the number of plays during an offensive drive; for basketball, it may be the number of consecutive missed baskets or made baskets; for hockey, it may be the number of consecutive shots for the home or away team, etc. If there are not enough odds created for the predetermined number of possibilities in the sequence, then the first sequence module 34326, may determine the wager odds for the next possibility, and the process may return to storing the wager odds in the odds database 34322. For example, in the odds database 34322, the odds for the at-bat to last one pitch is already stored, so the next possibility may be for the at-bat to last two pitches. For example, if J. D. Martinez has 100 at-bats versus the New York Yankees and out of those 100 at-bats only ten times did the at-bat last two pitches, then there may only be a 10% chance for the at-bat to be a two-pitch at-bat, which the odds may be 100:10 or displayed to the user as 10:1 odds for the at-bat to be a two-pitch at-bat. Since the predetermined number of possibilities is set at seven, then the first sequence module 34326, may repeat this loop until the odds are calculated for the at-bat to last one pitch, two pitches, three pitches, four pitches, five pitches, six pitches, and seven pitches. In some embodiments, the predetermined number of possibilities may be set at any number, and seven is only used as an example. If there are enough odds created for the predetermined number of possibilities in the sequence, then the first sequence module 34326 may send the sequence wager odds to the wagering app 34310. For example, the sequence odds sent to the wagering app 34310 may mean that the Boston Red Sox's J. D. Martinez at-bat may last one pitch, at 20:1 odds, two pitches, at 10:1 odds, three pitches, at 5:1 odds, etc. Then the first sequence module 126, may return to the base module 34324. Then the base module 34324 may continuously poll, at step 34402, for the user's wager data. For example, the user may wager on the number of pitches during the at-bat for J. D. Martinez during the 5th inning of the Boston Red Sox vs. the New York Yankees event. 34302. Then the base module 34324 may receive, at step 34404, the user's wager data. For example, the user may wager on the number of pitches during the at-bat for J. D. Martinez during the 5th inning of the Boston Red Sox vs. the New York Yankees event. The base module 34324 may store, at step 34406, the user's wager data in the user database 34316. The user's wager data may be information about the wager and the relevant results in the live event 34302. For example, the at-bat may last only one pitch, the wager odds, such as 20:1, the amount wagered, such as $20, and the user's information, such as user ID, address, e-mail, etc. Then the base module 124 may initiate, at step 34408, the additional sequence module 34328. For example, the additional sequence module 34328 may begin with the additional sequence module 34328 being initiated by the base module 34324. The additional sequence module 34328 may determine if the previous play has ended. For example, the additional sequence module 34328 may determine if the data has been received from the live event 34302 for the results of the play in the Boston Red Sox vs. New York Yankees game in the top of the 5th inning, with one out and J. D. Martinez at-bat with no pitches being thrown yet. If the previous play has not ended, then the additional sequence module 34328 may continuously poll for the play to conclude. For example, the additional sequence module 34328 may continuously poll to receive the data from the live event 34302 for the results of the play in the Boston Red Sox vs. New York Yankees game in the top of the 5th inning, with one out and J. D. Martinez at-bat with no pitches being thrown yet. If the previous play has concluded, then the additional sequence module 34328 may receive the upcoming play data from the live event 34302. For example, the additional sequence module 34328 may receive from the live event 34302 for the results of the play in the Boston Red Sox vs. New York Yankees game in the top of the 5th inning, with one out and J. D. Martinez at-bat with one pitch being thrown. Then the additional sequence module 128 may compare the upcoming play data to the odds database 34322. For example, the additional sequence module 34328 may compare the date of the event, the time of the event, the teams playing, the time within the event, and the players in the event to determine if there are current sequence odds available. For example, if the date is Jul. 8, 2021, the time of the event is 8:15 pm EST, the teams playing are the Boston Red Sox vs. the New York Yankees, the time within the event is the 5th inning, and the batter is J. D. Martinez then the odds database 34322 may contain the record of sequence odds created during the process described in the first sequence module 34326. The additional sequence module 34328 may determine if there is an existing sequence for the upcoming play. For example, the additional sequence module 34328 may compare the date of the event, the time of the event, the teams playing, the time within the event, and the players in the event to determine if there are current sequence odds available. For example, if the date is Jul. 8, 2021, the time of the event is 8:15 pm EST, the teams playing are the Boston Red Sox vs. the New York Yankees, the time within the event is the 5th inning, and the batter is J. D. Martinez then the odds database 34322 may contain the record of sequence odds created during the process described in the first sequence module 34326. If there is no sequence available in the odds database 34322, then the additional sequence module 34328 may return to the base module 34324. For example, the additional sequence module 34328 may return to the base module 34324 to create the first sequence odds. If there is a sequence available in the odds database 34322, then the additional sequence module 34328 may extract the sequence odds from the odds database 34322. For example, the data extracted may be the date is Jul. 8, 2021, the time of the event is 8:15 pm EST, the teams playing are the Boston Red Sox vs. the New York Yankees, the time within the event is the 5th inning, and the batter is J. D. Martinez, with the sequence odds of the at-bat may last one pitch, at 20:1 odds, two pitches, at 10:1 odds, three pitches, at 5:1 odds, etc. Then the additional sequence module 34328 may determine if there are odds created for the predetermined number of possibilities in the sequence. For example, the first pitch has occurred, so the odds of 20:1 for the at-bat to last one pitch may no longer be available to the user and thus removed from the sequence, this may result in the sequence only containing six possibilities, and that may not meet the predetermined threshold of seven possibilities and the corresponding odds. If there are not enough odds created for the predetermined number of possibilities in the sequence, then the additional sequence module 34328 may filter the historical plays database 34318 on the upcoming play data. For example, the historical plays database 34318 is filtered for the Boston Red Sox vs. the New York Yankees, in top of the 5th inning, with one out and the batter being J. D. Martinez. Then the additional sequence module 34328 may extract the data from the historical plays database 34318. For example, the first sequence module 34326 may extract all the historical wagering odds data associated with the event being the Boston Red Sox vs. New York Yankees game in the top of the 5th inning, with one out and J. D. Martinez at-bat with one pitch being thrown. The additional sequence module 34328 may determine the wager odds for the next possibility in the sequence. For example, the sequence odds for the at-bat to last two pitches through seven pitches may be stored in the odds database, so the additional sequence module may need to calculate the odds for the at-bat to last eight pitches. For example, if J. D. Martinez has 100 at-bats versus the New York Yankees and out of those 100 at-bats only 20 times did the at-bat last only eight pitches, then there may only be a 20% chance for the at-bat to last eight pitches, which the odds may be 100:20 or displayed to the user as 5:1 odds for the at-bat to last eight pitches. Then the additional sequence module 34328 may store the wager odds in the odds database 34322. For example, the 5:1 odds for the at-bat to last eight pitches may be stored with the current sequence odds in the odds database 34322. If there are enough odds created for the predetermined number of possibilities in the sequence, then the additional sequence module 34328 may send the sequence wager odds to the wagering app 34310, and the process may return to the additional sequence module 34328 returning to the base module 34324. For example, the sequence odds sent to the wagering app 34310 may mean that the Boston Red Sox's J. D. Martinez at-bat may be two pitches, at 10:1 odds, three pitches, at 5:1 odds, up to the eight pitches, at 5:1 odds.

FIG. 345 illustrates the first sequence module 34326. The process may begin with the base module 34324 initiating, at step 34500, the first sequence module 34326. The first sequence module 34326, may continuously poll, at step 34502, for the upcoming play data from the live event 34302. For example, the first sequence module 34326 may continuously poll to receive the data from the live event 34302 that represents the current state of the live event 34302, such as in the Boston Red Sox vs. New York Yankees game it is the top of the 5th inning, with one out and J. D. Martinez at-bat with no pitches being thrown yet. Then the first sequence module 34326, may receive, at step 34504, the upcoming play data from the live event 34302. For example, the upcoming play data may be in the Boston Red Sox vs. New York Yankees game. It is the top of the 5th inning, with one out and J. D. Martinez at-bat with no pitches being thrown yet. The first sequence module 34326 may filter, at step 34506, the historical plays database 34318 on the upcoming play data. For example, the historical plays database 34318 is filtered for the Boston Red Sox vs. the New York Yankees, in top of the 5th inning, with one out and the batter being J. D. Martinez. Then the first sequence module 34326 may extract, at step 34508, the data from the historical plays database 34318. For example, the first sequence module 34326 may extract all the historical wagering odds data associated with the event being the Boston Red Sox vs. New York Yankees game in the top of the 5th inning, with one out and J. D. Martinez at-bat with no pitches being thrown yet. The first sequence module 34326, may determine, at step 34510, the wager odds. For example, the first sequence module 34326 may determine the average wager odds from the odds of the historical wager extracted from the historical plays database 34318, such as the number of times or occasions that the Boston Red Sox's J. D. Martinez at-bat lasted only one pitch versus the New York Yankees. For example, if J. D. Martinez has 100 at-bats versus the New York Yankees and out of those 100 at-bats only five times did the at-bat last only one pitch, then there may only be a 5% chance for the at-bat to be a one-pitch at-bat, which the odds may be 100:5 or displayed to the user as 20:1 odds for the at-bat to be a one-pitch at-bat. Then the first sequence module 34326 may store, at step 34512, the wager odds in the odds database 34322 as a sequence. Wherein the wager odds sequence may be a series of wager odds possibilities for a play based on the play data and historical play data. For example, the wager odds 20:1 are stored in the odds database 34322 for the Boston Red Sox's J. D. Martinez at-bat lasted only one pitch versus the New York Yankees. Then the first sequence module 34326 may determine, at step 34514, if odds are created for a predetermined number of possibilities in the sequence. For example, there may need to be other odds calculated for the number of pitches thrown during the Boston Red Sox's J. D. Martinez at-bat versus the New York Yankees, such as two pitches, three pitches, four pitches, etc. and the predetermined number of possibilities may be set at seven. For example, for every at-bat, the wagering network offers users odds for the number of pitches that may occur during an at-bat, with each pitch having different odds, such as the at-bat lasting one pitch at 20:1 odds. In some embodiments, the sequence odds may be determined differently for different sports; for example, in baseball, the sequence odds may be for pitches during an at-bat; for football, it may be the number of plays during an offensive drive; for basketball, it may be the number of consecutive missed baskets or made baskets, for hockey it may be the number of consecutive shots for the home or away team, etc. If there are not enough odds created for the predetermined number of possibilities in the sequence, then the first sequence module 34326 may determine, at step 34516, the wager odds for the next possibility, and the process may return to storing the wager odds in the odds database 34322 at step 34512. For example, in the odds database 34322, the odds for the at-bat to last one pitch is already stored, so the next possibility may be for the at-bat to last two pitches. For example, if J. D. Martinez has 100 at-bats versus the New York Yankees and out of those 100 at-bats only ten times did the at-bat last two pitches, then there may only be a 10% chance for the at-bat to be a two-pitch at-bat, which the odds may be 100:10 or displayed to the user as 10:1 odds for the at-bat to be a two-pitch at-bat. Since the predetermined number of possibilities is set at seven, then the first sequence module 34326, may repeat this loop until the odds are calculated for the at-bat to last one pitch, two pitches, three pitches, four pitches, five pitches, six pitches, and seven pitches. In some embodiments, the predetermined number of possibilities may be set at any number, and seven is only used as an example. If there are enough odds created for the predetermined number of possibilities in the sequence, then the first sequence module 34326 may send, at step 34518, the sequence wager odds to the wagering app 34310. For example, the sequence odds sent to the wagering app 34310 may mean that the Boston Red Sox's J. D. Martinez at-bat may last one pitch, at 20:1 odds, two pitches, at 10:1 odds, three pitches, at 5:1 odds, etc. Then the first sequence module 34326, may return, at step 34520, to the base module 34324.

FIG. 346 illustrates the additional sequence module 34328. The process may begin with the additional sequence module 34328 being initiated, at step 34600, by the base module 34324. The additional sequence module 34328 may determine, at step 34602, if the previous play has ended. For example, the additional sequence module 34328 may determine if the data has been received from the live event 34302 for the results of the play in the Boston Red Sox vs. New York Yankees game in the top of the 5th inning, with one out and J. D. Martinez at-bat with no pitches being thrown yet. If the previous play has not ended, then the additional sequence module 34328 may continuously poll, at step 34604, for the play to conclude. For example, the additional sequence module 34328 may continuously poll to receive the data from the live event 34302 for the results of the play in the Boston Red Sox vs. New York Yankees game in the top of the 5th inning, with one out and J. D. Martinez at-bat with no pitches being thrown yet. If the previous play has concluded, then the additional sequence module 34328 may receive, at step 34606, the upcoming play data from the live event 34302. For example, the additional sequence module 34328 may receive from the live event 34302 for the results of the play in the Boston Red Sox vs. New York Yankees game in the top of the 5th inning, with one out and J. D. Martinez at-bat with one pitch being thrown. Then the additional sequence module 34328 may compare, at step 34608, the upcoming play data to the odds database 34322. For example, the additional sequence module 34328 may compare the date of the event, the time of the event, the teams playing, the time within the event, and the players in the event to determine if there are current sequence odds available. For example, if the date is Jul. 8, 2021, the time of the event is 8:15 pm EST, the teams playing are the Boston Red Sox vs. the New York Yankees, the time within the event is the 5th inning, and the batter is J. D. Martinez then the odds database 34322 may contain the record of sequence odds created during the process described in the first sequence module 34326. The additional sequence module 34328 may determine, at step 34610, if there is an existing sequence for the upcoming play. For example, the additional sequence module 34328 may compare the date of the event, the time of the event, the teams playing, the time within the event, and the players in the event to determine if there are current sequence odds available. For example, if the date is Jul. 8, 2021, the time of the event is 8:15 pm EST, the teams playing are the Boston Red Sox vs. the New York Yankees, the time within the event is the 5th inning, and the batter is J. D. Martinez then the odds database 34322 may contain the record of sequence odds created during the process described in the first sequence module 34326. If there is no sequence available in the odds database 34322, then the additional sequence module 34328 may return, at step 34612, to the base module 34324. For example, the additional sequence module 34328 may return to the base module 34324 to create the first sequence odds. If there is a sequence available in the odds database 34322, then the additional sequence module 34328 may extract, at step 34614, the sequence odds from the odds database 34322. For example, the data extracted may be the date is Jul. 8, 2021, the time of the event is 8:15 pm EST, the teams playing are the Boston Red Sox vs. the New York Yankees, the time within the event is the 5th inning, and the batter is J. D. Martinez, with the sequence odds of the at-bat may last one pitch, at 20:1 odds, two pitches, at 10:1 odds, three pitches, at 5:1 odds, etc. Then the additional sequence module 128 may determine, at step 34616, if odds are created for the predetermined number of possibilities in the sequence. For example, the first pitch has occurred so the odds of 20:1 for the at-bat to last one pitch may no longer be available to the user and thus removed from the sequence, this may result in the sequence only containing six possibilities, and that may not meet the predetermined threshold of seven possibilities and the corresponding odds. If there are not enough odds created for the predetermined number of possibilities in the sequence, then the additional sequence module 34328 may filter, at step 34618, the historical plays database 34318 on the upcoming play data. For example, the historical plays database 34318 is filtered for the Boston Red Sox vs. the New York Yankees, in top of the 5th inning, with one out and the batter being J. D. Martinez. Then the additional sequence module 34328 may extract, at step 34620, the data from the historical plays database 34318. For example, the first sequence module 34326 may extract all the historical wagering odds data associated with the event being the Boston Red Sox vs. New York Yankees game in the top of the 5th inning, with one out and J. D. Martinez at-bat with one pitch being thrown. The additional sequence module 34328 may determine, at step 34622, the wager odds for the next possibility in the sequence. For example, the sequence odds for the at-bat to last two pitches through seven pitches may be stored in the odds database, so the additional sequence module may need to calculate the odds for the at-bat to last eight pitches. For example, if J. D. Martinez has 100 at-bats versus the New York Yankees and out of those 100 at-bats only 20 times did the at-bat last only eight pitches, then there may only be a 20% chance for the at-bat to last eight pitches, which the odds may be 100:20 or displayed to the user as 5:1 odds for the at-bat to last eight pitches. Then the additional sequence module 34328 may store, at step 34624, the wager odds in the odds database 34322 and return to step 34616. For example, the 5:1 odds for the at-bat to last eight pitches may be stored with the current sequence odds in the odds database 34322. If there are enough odds created for the predetermined number of possibilities in the sequence, then the additional sequence module 34328 may send, at step 34626, the sequence wager odds to the wagering app 34310, and the process may return to the additional sequence module 34328 returning to the base module 34324. For example, the sequence odds sent to the wagering app 34310 may mean that the Boston Red Sox's J. D. Martinez at-bat may be two pitches, at 10:1 odds, three pitches, at 5:1 odds, up to the eight pitches, at 5:1 odds.

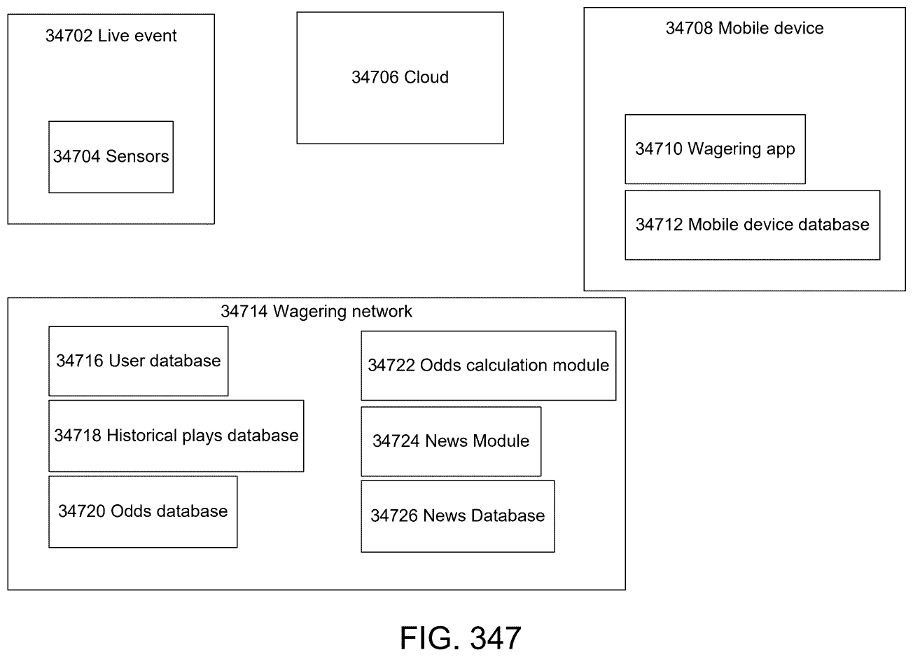

FIG. 347 illustrates a system for displaying news related to a player, according to an embodiment.

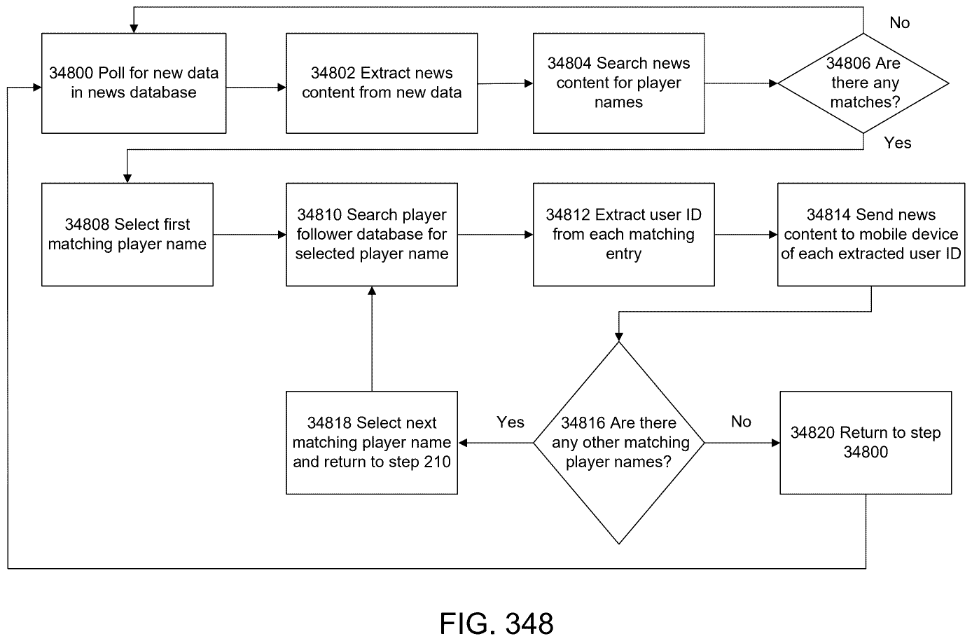

FIG. 348 illustrates a player news module, according to an embodiment.

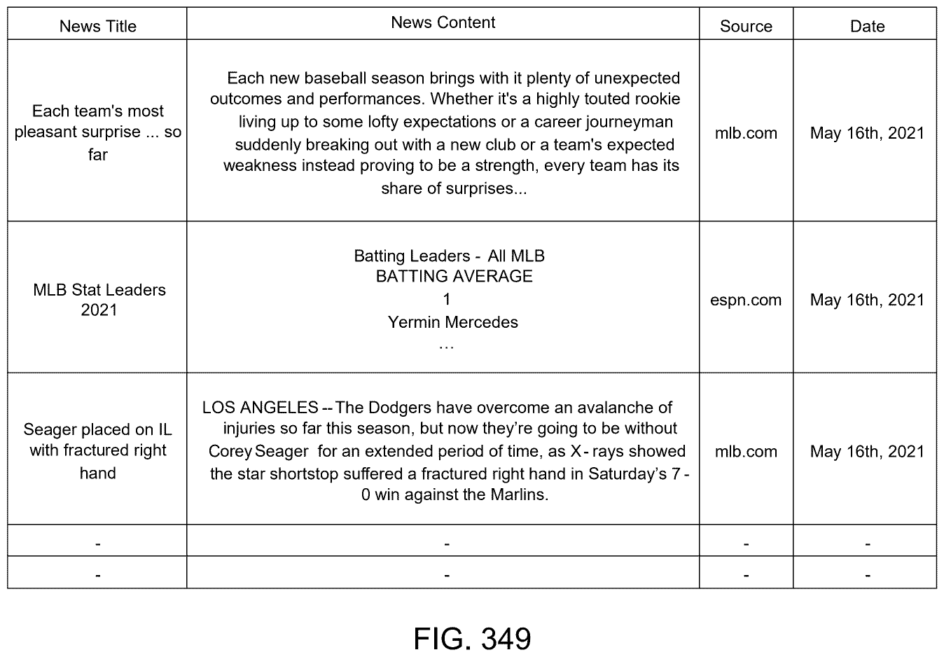

FIG. 349 illustrates a news database, according to an embodiment.

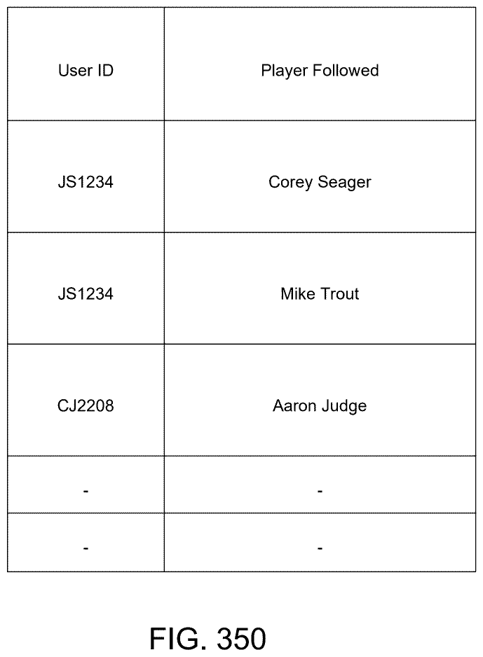

FIG. 350 illustrates a player follower database, according to an embodiment.

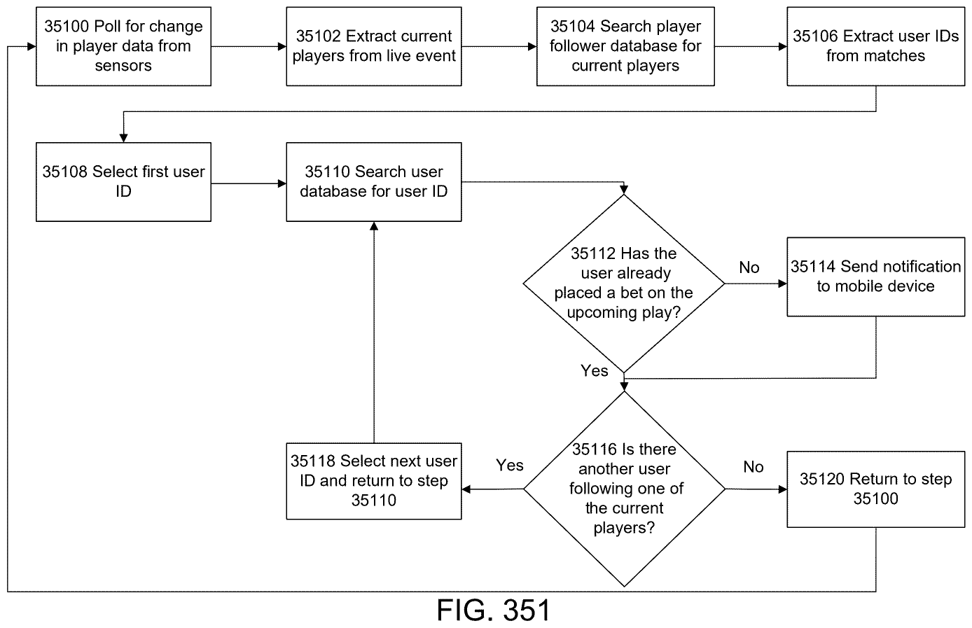

FIG. 351 illustrates a player wager module, according to an embodiment.

FIG. 347 is a system for displaying news related to a player. This system may include a live event 34702, for example, a sporting event such as a football, basketball, baseball, or hockey game, tennis match, golf tournament, eSports, or digital game, etc. The live event 34702 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 34702, such as the score of an American football game or the run line in a baseball game, or a series of actions in the live event 34702. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 34702 or at another location.

Further, embodiments may include a plurality of sensors 34704 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 34704 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 34706 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 34706 may be communicatively coupled to a peer-to-peer wagering network 34714, which may perform real-time analysis on the type of play and the result of the play. The cloud 34706 may also be synchronized with game situational data such as the time of the game, the score, location on the field, weather conditions, and the like, which may affect the choice of play utilized. For example, in an exemplary embodiment, the cloud 34706 may not receive data gathered from the sensors 34704 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 34708 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 34708 could be an optional component and would be utilized in a situation where a paired wearable device employs the mobile device 34708 for additional memory or computing power or connection to the internet.

Further, embodiments may include a wagering software application or a wagering app 34710, which is a program that enables the user to place bets on individual plays in the live event 34702, streams audio and video from the live event 34702, and features the available wagers from the live event 34702 on the mobile device 34708. The wagering app 34710 allows the user to interact with the wagering network 34714 to place bets and provide payment/receive funds based on wager outcomes.

Further, embodiments may include a mobile device database 34712 that may store some or all the user's data, the live event 34702, or the user's interaction with the wagering network 34714.

Further, embodiments may include the wagering network 34714, which may perform real-time analysis on the type of play and the result of a play or action. The wagering network 34714 (or the cloud 34706) may also be synchronized with game situational data, such as the time of the game, the score, location on the field, weather conditions, and the like, which may affect the choice of play utilized. For example, in an exemplary embodiment, the wagering network 34714 may not receive data gathered from the sensors 34704 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 34714 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 34716, which may contain data relevant to all users of the wagering network 34714 and may include, but is not limited to, a user ID, a device identifier, a paired device identifier, wagering history, or wallet information for the user. The user database 34716 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 34716 may contain betting lines and search queries. The user database 34716 may be searched based on a search criterion received from the user. Each betting line may include but is not limited to, a plurality of betting attributes such as at least one of the following: the live event 34702, a team, a player, an amount of wager, etc. The user database 34716 may include, but is not limited to, information related to all the users involved in the live event 34702. In one exemplary embodiment, the user database 34716 may include information for generating a user authenticity report and a wagering verification report. Further, the user database 34716 may be used to store user statistics like, but not limited to, the retention period for a particular user, frequency of wagers placed by a particular user, the average amount of wager placed by each user, etc.

Further, embodiments may include a historical plays database 34718 that may contain play data for the type of sport being played in the live event 34702. For example, in American Football, for optimal odds calculation, the historical play data may include metadata about the historical plays, such as time, location, weather, previous plays, opponent, physiological data, etc.

Further, embodiments may utilize an odds database 34720—that may contain the odds calculated by an odds calculation module 34722—to display the odds on the user's mobile device 34708 and take bets from the user through the mobile device wagering app 110.

Further, embodiments may include the odds calculation module 34722, which may utilize historical play data to calculate odds for in-play wagers.

Further, embodiments may include a player news module 34724, which may find which players a user may follow from the player follower database 34728 and search for relevant news data in the news database 34726. The news data may then be sent to the mobile device 34708 to be displayed by the wagering app 34710. Relevant news data may be determined by finding information in the news data related to the followed player or players.

Further, embodiments may include a news database 34726 containing news data related to the live event 34702. News data may include news articles, stats, reports, opinions, live commentary, etc. The data may contain meta tags for easier searching. News data related to the live event 34702 may be news about the live event 34702, the teams, the players, similar teams or players, similar events, weather, etc.

Further, embodiments may include a player follower database 34728, which may contain a list of players that a user is following. Following may mean that the user has expressed an interest, or has shown by past behavior, that they want to receive updates and news about the player.

Further, embodiments may include a player wager module 34730, which may direct users to wager options available for players they follow.

FIG. 348 illustrates the player news module 34724. The process may begin with the player news module 34724 polling, at step 34800, for a new data entry in the news database 34726. An entry in the news database 34726 may correspond with the publication of a new news story or new statistics, which may then be automatically or manually entered into the news database 34726. The player news module 34724 may extract, at step 34802, the news content from the new data entry. The player news module 34724 may also extract metadata, the title, the date, or any other data in the entry, which may be used to identify if the news data is relevant to any players. The player news module 34724 may search, at step 34804, the extracted news content for player names. For example, this string of text from a news article, “now they're going to be without Corey Seager for an extended period of time,” contains the name of the player Corey Seager. This search may be a text search which may include variations of the player's name. For example, shortened versions of the name such as “Bob” instead of “Robert” or “Bobby,” or misspellings of the name, for example, “Micheal” instead of “Michael.” The search may also use search algorithms to determine if the name is being used in a significant context. For example, if the players' names appear in a paragraph of an article, it may be significant, but if the name is just one in a list of 100 with no other context, it may not be. The search may also search the title or metadata of the news data if they were extracted in step 34802. Player names may be stored, and variations may be stored in the player follower database 34728 or retrieved from publicly available sources. The player news module 34724 may determine, at step 34806, if there are any player name matches in the news content. If there are no player names, the player news module may return to step 34800. If there are player name matches in the news content, the player news module 34724 may select, at step 34808, the first matching player name. The player news module 34724 may search, at step 34810, the player follower database 34726 for the selected player name. If the name is a variation of the player's name, it may be changed to the player's name that is used for the player follower database 34728 The player news module 34724 may extract, at step 34812, the user ID of each entry that has a player name that matches the selected player name. For example, if the first matching player name in the news content is Corey Seager and user JS1234 follows Corey Seager, the user ID JS1234 may be extracted. The player news module 34724 may send, at step 34814, the news content to the mobile device 34708 associated with each extracted user ID. This content may then be displayed via the wagering app 34710. The player news module 34724 may determine, at step 34816, if there are any other matching player names in the news content. If there are other matching player names in the news content, the player news module 34724 may select, at step 34818, the next player's name and return to step 34810. If there are no other matching player names in the news content, the player news module 34724 may return, at step 34820, to step 34800.

FIG. 349 illustrates the news database 34726. The news database 34726 may contain news data that may be useful to users in deciding how to wager. The news database 34726 may contain news articles relevant to the live event 34702, the teams, the players, similar teams or players, similar events, weather, or any other factor that may inform the user about how best to place their wager. The news database 34726 may contain titles and content for each entry, a source where the news data was obtained, and a date.

FIG. 350 illustrates the player follower database 34728. The player follower database may contain the names of players that a user is following and the user's user ID. This database may be populated manually by users selecting which players to follow or by a module that tracks user behavior to identify which players they are most interested in.

FIG. 351 illustrates the player wager module 34730. The process may begin with the player wager module 34730 polling, at step 35100, for a change in player data from the sensors 34704 of the live event 34702. A change in player data may occur when a new player becomes active in the next play, for example, the next at-bat in baseball or a substitution in American football. The player wager module 34730 may extract, at step 35102, data on the current players of the live event 34702. Current players may refer to players taking part in the current or upcoming play of the live event 34702. The player wager module 34730 may search, at step 35104, the player follower database 34728 for each of the current players of the live event 34702. Alternatively, the player wager module 34730 may only search for the players that recently became active in the live event 34702. The player wager module 34730 may extract, at step 35106, the user IDs of users following the current players. The player wager module 34730 may select, at step 35108, the first extracted user ID. The player wager module 34730 may search, at step 35110, the user database 34716 for the user ID. The player wager module 34730 may determine, at step 35112, if the user has already placed a wager on the current or upcoming play of the live event 34702. This determination may be made by checking if the selected user ID has a wager associated with it in the user database 34716 that corresponds to the current or upcoming play of the live event 34702. If the user has already placed a wager on the current or upcoming play of the live event 34702, the player wager module may skip to step 35116. If the user has not already placed a bet on the current or upcoming play of the live event 34702, the player wager module 34730 may send, at step 35114, a notification to the mobile device 34708 associated with the selected user ID. The notification may include an indication that a wager on a followed player is available. For example, the notification may read, “Aaron Judge just took the field. Place your bets now!”. The notification may include a link that directs to a menu where the user can place a wager on the play in the wagering app 34710. The player wager module 34730 may determine, at step 35116, if another user follows one of the current players of the live event 34702. If another user follows one of the current players of the live event 34702, the player wager module 34730 may select, at step 35118, the next user ID and return to step 35110. If there is not another user following one of the current players of the live event 34702, the player wager module 34730 may return, at step 35120, to step 35100.

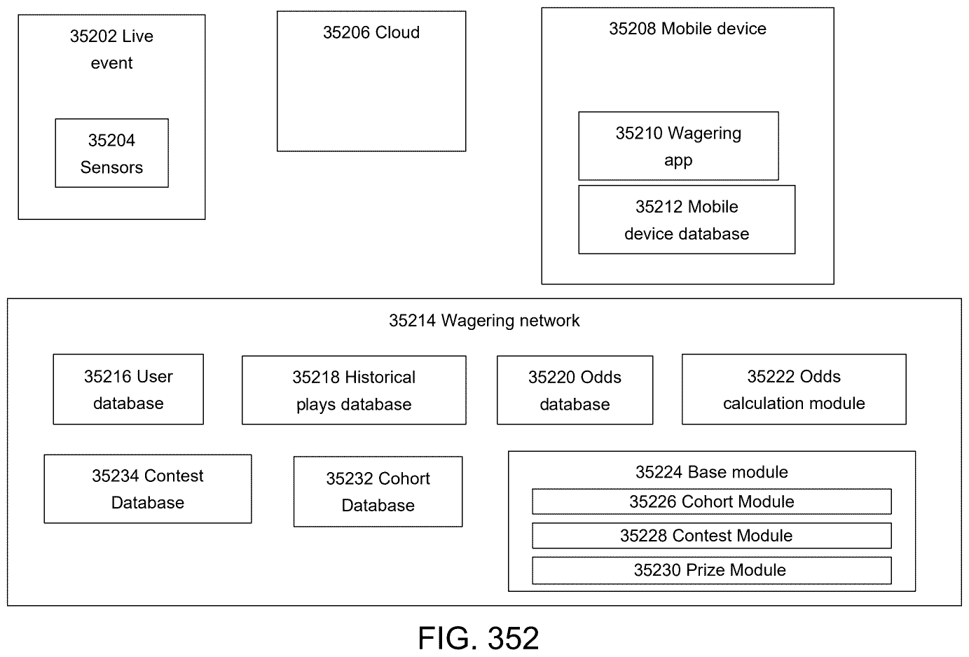

FIG. 352 illustrates a system for in-play wagering for contest prizes by wins, according to an embodiment.

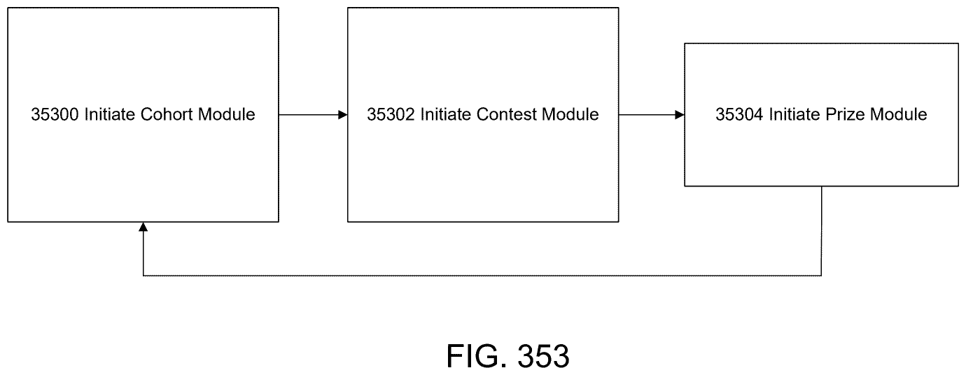

FIG. 353 illustrates a base module, according to an embodiment.

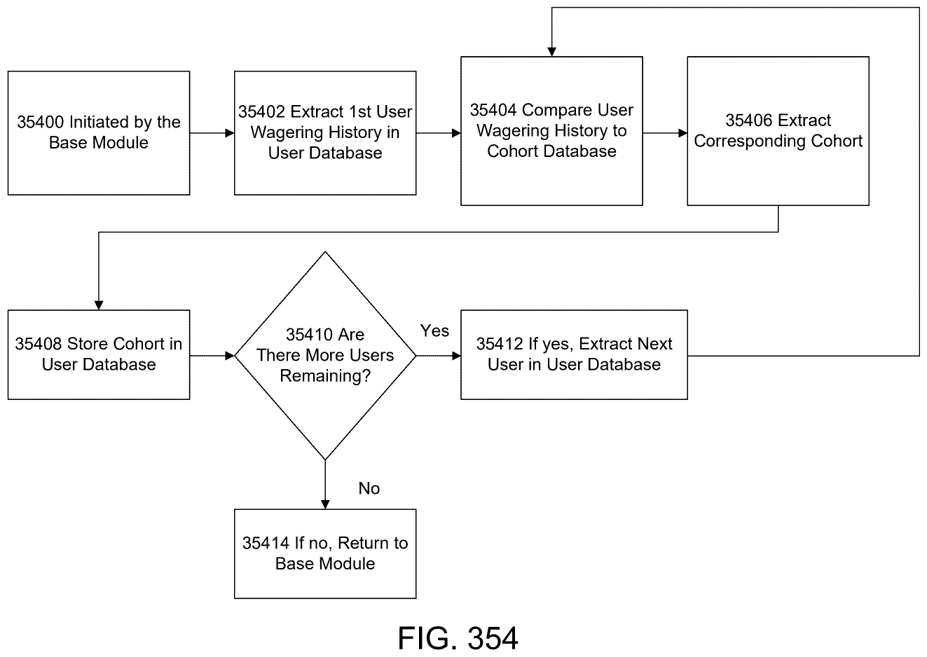

FIG. 354 illustrates a cohort module, according to an embodiment.

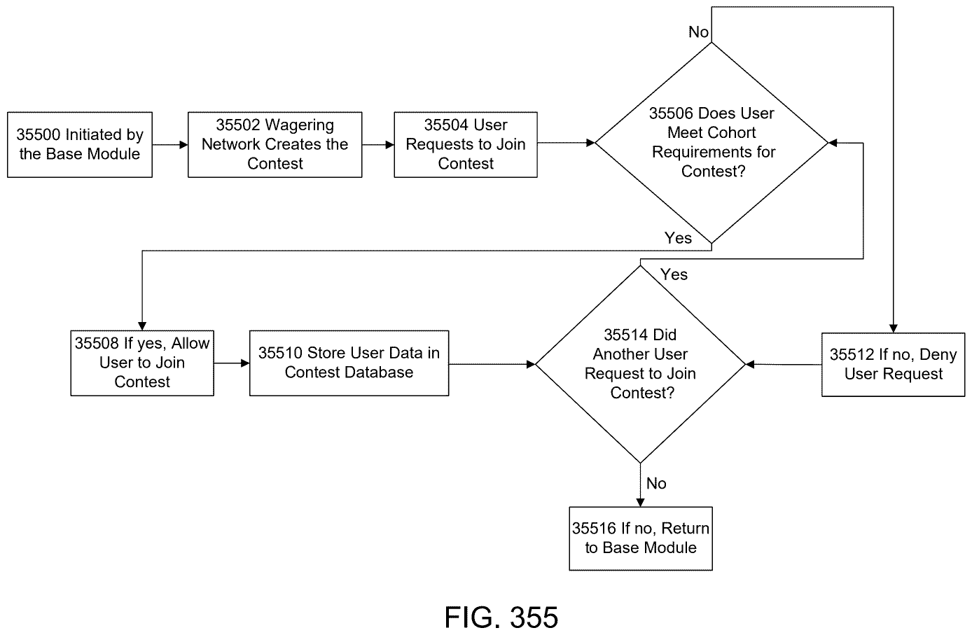

FIG. 355 illustrates a contest module, according to an embodiment.

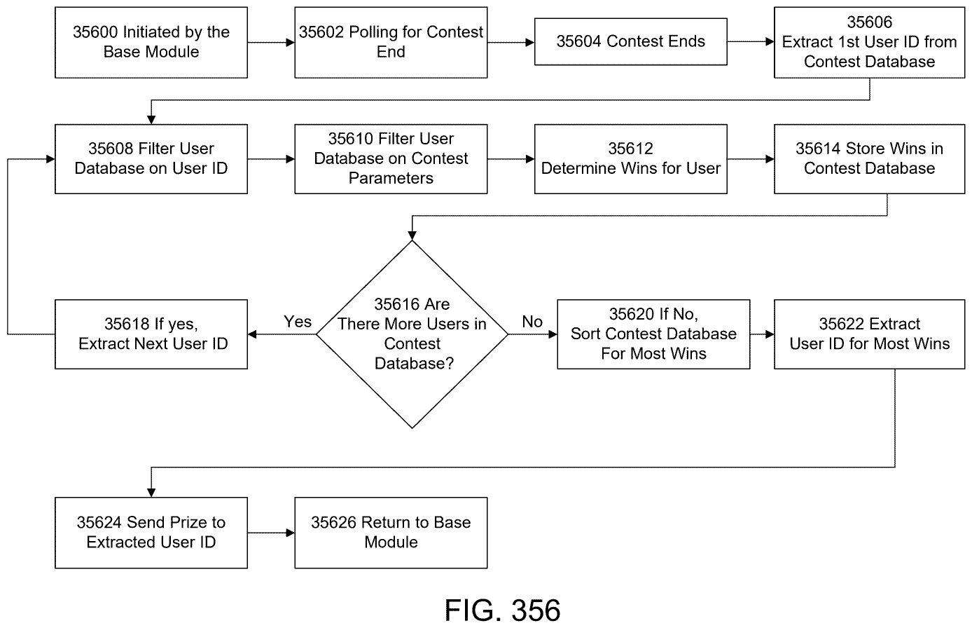

FIG. 356 illustrates a prize module, according to an embodiment.

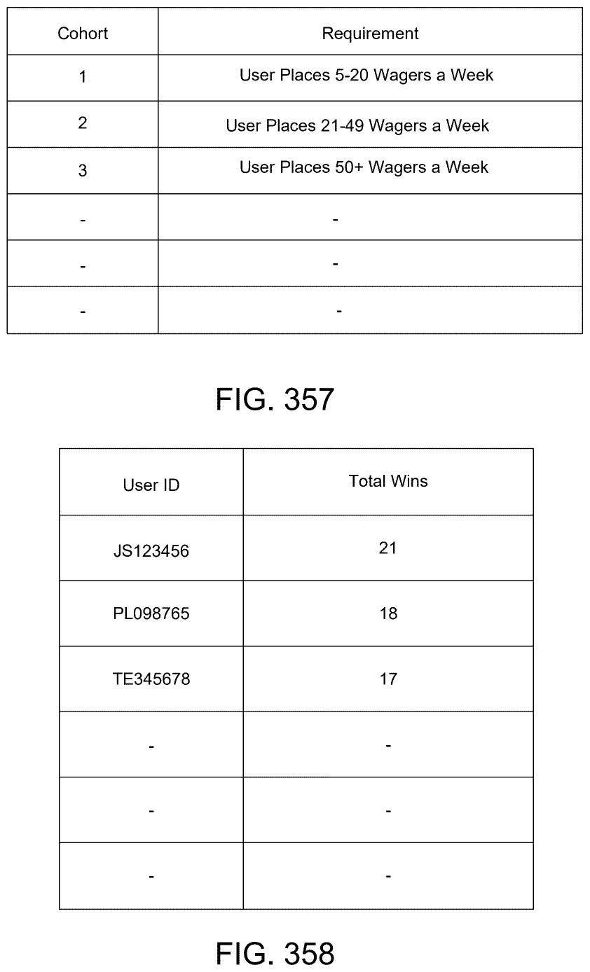

FIG. 357 illustrates a cohort database, according to an embodiment.

FIG. 358 illustrates a contest database, according to an embodiment.

FIG. 352 is a system for in-play wagering for contest prizes by wins. This system may include a live event 35202, for example, a sporting event such as a football, basketball, baseball, or hockey game, tennis match, golf tournament, eSports or digital game, etc. The live event 35202 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 35202, such as the score of an American football game or the run line in a baseball game, or a series of actions in the live event 35202. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 35202 or at another location.

Further, embodiments may include a plurality of sensors 35204 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 35204 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 35206 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 35206 may be communicatively coupled to a peer-to-peer wagering network 35214, which may perform real-time analysis on the type of play and the result of the play. The cloud 35206 may also be synchronized with game situational data such as the time of the game, the score, location on the field, weather conditions, and the like, which may affect the choice of play utilized. For example, in an exemplary embodiment, the cloud 35206 may not receive data gathered from the sensors 35204 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 35208 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 35208 could be an optional component and would be utilized in a situation where a paired wearable device employs the mobile device 35208 for additional memory or computing power or connection to the internet.

Further, embodiments may include a wagering software application or a wagering app 35210, which is a program that enables the user to place bets on individual plays in the live event 35202, streams audio and video from the live event 35202, and features the available wagers from the live event 35202 on the mobile device 35208. The wagering app 35210 allows users to interact with the wagering network 35214 to place bets and provide payment/receive funds based on wager outcomes.

Further, embodiments may include a mobile device database 35212 that may store some or all the user's data, the live event 35202, or the user's interaction with the wagering network 35214.

Further, embodiments may include the wagering network 35214, which may perform real-time analysis on the type of play and the result of a play or action. The wagering network 35214 (or the cloud 35206) may also be synchronized with game situational data, such as the time of the game, the score, location on the field, weather conditions, and the like, which may affect the choice of play utilized. For example, in an exemplary embodiment, the wagering network 35214 may not receive data gathered from the sensors 35204 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 35214 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 35216, which may contain data relevant to all users of the wagering network 35214 and may include, but is not limited to, a user ID, a device identifier, a paired device identifier, wagering history, or wallet information for the user. The user database 35216 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 35216 may contain betting lines and search queries. The user database 35216 may be searched based on a search criterion received from the user. Each betting line may include, but is not limited to, a plurality of betting attributes such as at least one of the following: the live event 35202, a team, a player, an amount of wager, etc. The user database 35216 may include but is not limited to information related to all the users involved in the live event 35202. In one exemplary embodiment, the user database 35216 may include information for generating a user authenticity report and a wagering verification report. Further, the user database 35216 may be used to store user statistics like, but not limited to, the retention period for a particular user, frequency of wagers placed by a particular user, the average amount of wager placed by each user, etc.

Further, embodiments may include a historical plays database 35218 that may contain play data for the type of sport being played in the live event 35202. For example, in American Football, for optimal odds calculation, the historical play data may include metadata about the historical plays, such as time, location, weather, previous plays, opponent, physiological data, etc.

Further, embodiments may utilize an odds database 35220—that contains the odds calculated by an odds calculation module 35222—to display the odds on the user's mobile device 35208 and take bets from the user through the mobile device wagering app 35210.

Further, embodiments may include the odds calculation module 35222, which utilizes historical play data 35218 to calculate odds for in-play wagers.

Further, embodiments may include a base module 35224, which initiates a cohort module 35226, a contest module 35228, and a prize module 35230.

Further, embodiments may include the cohort module 35226, which may be initiated by the base module 35224. The cohort module 35226 may extract the first user wagering history in the user database 35216. For example, the user database 35216 may contain the user ID, a device identifier, a paired device identifier, wagering history, or wallet information for the user. The cohort module 35226 may then compare the extracted user wager history to a cohort database 35232. For example, if the user places ten wagers per week, the user may be placed in cohort 1 since the requirement for cohort 1 is that a user places between 5 and 20 wagers a week. The cohort module 35226 may extract the corresponding cohort from the cohort database 35232. For example, the cohort module 35226 may extract the cohort number, such as 1, from the cohort database 35232. The cohort module 35226 may then store the extracted cohort in the user database 35216. For example, the cohort module 35226 stores cohort 1 in the user database 35216. The cohort module 35226 may then determine if more users are remaining in the user database 35216. For example, the cohort module 35226 may go through each user in the user database 35216 and give a cohort to each user. If there are additional users in the user database 35216, the cohort module 35226 may then extract the next user's wagering history from the user database 35216. The process may then return to comparing the wagering history with the cohort database 35232. If there are no more users remaining in the user database 35216, the cohort module 35226 may then return to the base module 35224.

Further, embodiments may include the contest module 35228, which may begin with the base module 35224 initiating the contest module 35228. The wagering network 35214 may then create a contest. For example, the wagering network 35214 may create a contest allowing users of the same cohort to participate against one another during the live event 35202, a series of live events 35202, live events 35202 for a certain time such as hour, day or days, week or weeks, month or months, etc. In some embodiments, the contest may be for users within a certain city, state, region, or other geographical requirements. In some embodiments, the contest may be for fans of certain teams, sports, etc. In some embodiments, a user may be able to invite other users to the contest. In some embodiments, the contest may be advertised with a prize, such as free credits, merchandise or swag, travel or vacation prizes, etc. In some embodiments, the contest may require a certain number of players play or a maximum number of players allowed in the contest. In some embodiments, a user may receive an offer to join the contest through the wagering app 35210. A user may request to join the contest. The user may be approved if they meet the cohort requirements for the contest. For example, the contest module 35228 may filter the user database 35216 for the requesting user ID and extract the user's cohort number, such as 1, and determine if the cohort number matches the cohort requirement for the contest. The cohort number provides users with the ability to compete in a contest with users of similar skill or expertise. If the user meets the cohort requirements for the contest, the contest module 35228 may then allow the user to join the contest. For example, the user may receive a notification that they have been approved or have joined a contest. The contest module 35228 may then store the user data in a contest database 35234. For example, the contest module 35228 may store the user ID, such as JS123456, in the contest database 35234. If the user does not meet the cohort requirements for the contest, the contest module 35228 may then deny the user's request to join the contest. For example, the user may receive a notification that informs them that they were rejected from joining or cannot join the contest. The contest module 35228 may then determine if another user has requested to join the contest. If another user requested to join the contest, then the process returns to check that the user meets the cohort requirements for the contest. If no other user requests to join the contest, the contest module 35228 may then return to the base module 35224.

Further, embodiments may include the prize module 35230, which begins with the base module 35224 initiating the prize module 35230. The prize module 35230 may continuously poll for the contest to end. For example, a contest may end at the completion of a live event 35202 such as the Boston Red Sox vs. New York Yankees game. In some embodiments, the contest may end at the finish of a series of live events 35202. In some embodiments, the contest may end after a certain time, such as hour, day or days, week or weeks, month or months, etc. The contest may then end. The prize module 35230 may then extract the first user ID from the contest database 35234. For example, the user ID JS123456 may be extracted from the contest database 35234. The prize module 35230 may then filter the user database 35216 for the extracted user ID. For example, the user database 35216 may be filtered for the user ID JS123456's wagering history. The prize module 35230 may filter the user database 35216 for the contest parameters. For example, the user database 35216 may be filtered for the live event 35202, series of live events 35202, time that the contest was active for, etc. Further, if the contest were for the live event 35202, such as the Boston Red Sox vs. New York Yankees game on June 14th, the user database 35216 may be filtered for wagers that only occurred on June 14th, for the Boston Red Sox vs. New York Yankees game. The same logic would apply if, for example, the contest was for all baseball events for the week of May 23rd through May 30th. The user database 35216 may be filtered for the baseball wagers from May 23rd to May 30th and the user's wagering history for the contest. The prize module 35230 may then determine the user's total amount of wins. For example, the user database 35216 may be filtered for the wagering history that applies to the contest allowing the prize module 35230 to count the user's wins. If the user had won 21 wagers during the live event 35202 Boston Red Sox vs. New York Yankees game, then the 21 “wins” may be extracted. The prize module 35230 may store the total amount of wins for the user in the contest database 35234. For example, the prize module 35230 may store the 21 extracted “wins” in the contest database 35234 for the user with the ID JS123456. The prize module 35230 may determine if there are remaining users in the contest database 35234. If so, the prize module 35230 may extract the next user ID and return to filtering the user database 35216 for the extracted user ID. If there are no remaining users in the contest database 35234, the prize module 35230 may sort the contest database 35234 for the most wins. For example, the prize module 35230 may sort the contest database 35234 for total wins by the highest to lowest number to determine which user has won the contest. The prize module 35230 may extract the user ID with the most wins. For example, if the user ID JS123456 has the most wins at 21, it may be extracted from the contest database 35234. The prize module 35230 may send a prize, such as free credits, merchandise or swag, travel or vacation prizes, etc. to the extracted user ID. For example, the prize module 35230 may send the user with the ID JS123456 a prize of $25 credits for winning the contest. The prize module 35230 may return to the base module 35224.

Further, embodiments may include the cohort database 35232, which may contain a cohort, such as 1, 2, 3, etc. with the cohort's requirements to join for potential users, such as, the user places 5-20 wagers a week, the user places 21-49 wagers a week, or the user places 50 or more wagers a week. The cohort database 35232 may be used in the process described above for the cohort module 35226 to place users in cohorts representative of their skill level for the wagering app 35210. In some embodiments, the cohort database 35232 requirements may use historical wagering patterns for a day, week, month, year, etc. In some embodiments, the cohort database 35232 requirements may be based on monetary value, such as, the more money spent by a user, the higher the cohort.

Further, embodiments may include the contest database 35234, which may contain the user IDs for the users in the contest, such as JS123456, and the user's total amount of wins, such as 21. The contest database 35234 may be used in the process described above for the contest module 35228 to store the user IDs for users included in the contest. Also, the contest database 35234 may be used in the process described above for the prize module 35230 to determine and store the total amount of wins for each user in the contest. In some embodiments, the contest database 35234 may include the contest parameters such as the live event 35202, the series of live events 35202, the live events 35202 over certain times, such as hour, day or days, week or weeks, month or months, etc. In some embodiments, the contest database 35234 may include the geographical requirements for the contest, such as users within a certain city, state, region, or other geographical requirements. In some embodiments, the contest database 35234 may include prize such as free credits, merchandise or swag, travel or vacation prizes, etc. In some embodiments, the contest database 35234 may include the minimum or the maximum number of entries for the contest and either the total number of entries for the contest or the total number of entries for each user.

FIG. 353 illustrates the base module 35224. The process begins with the base module initiating, at step 35300, the cohort module 35226. The cohort module 35226 may extract the first user wagering history from the user database 35216 which may include the user ID, a device identifier, a paired device identifier, wagering history, or wallet information for the user. The cohort module 35226 may compare the extracted user wager history to the cohort database 35232. For example, if the user places ten wagers per week, the user may be placed in cohort 1 since the requirement for cohort 1 is that a user places between 5 and 20 wagers a week. The cohort module 35226 may extract the corresponding cohort number. For example, the cohort module 35226 may extract the cohort number, such as 1, from the cohort database 35232. The cohort module 35226 may store the extracted cohort number in the user database 35216. For example, the cohort module 35226 may store cohort 1 in the user database 35216. The cohort module 35226 may then determine if there are remaining users in the user database 35216. For example, the cohort module 35226 may go through each user in the user database 35216 and give a cohort to each user. If there are more users in the user database 35216, the cohort module 35226 may extract the next user's wagering history from the user database 35216. The cohort module 35226 may then returns to comparing the wagering history from the cohort database 35232. If there are no users remaining in the user database 35216, the cohort module 35226 may return to the base module 35224. The base module 35224 may initiate, at step 35302, the contest module 35228. For example, the wagering network 35214 creates the contest which may allow users of the same cohort to participate against one another during a live event 35202, a series of live events 35202, live events 35202 for a certain time such as hour, day or days, week or weeks, month or months, etc. in some embodiments, the contest may be for users within a certain city, state, region, or other geographical requirements. In some embodiments, the contest may be for fans of certain teams, sports, etc. In some embodiments, a user may be able to invite other users to the contest. In some embodiments, the contest may be advertised with a prize such as free credits, merchandise or swag, travel or vacation prizes, etc. In some embodiments, the contest may have a certain number of players required to play or the maximum number of players allowed in the contest. In some embodiments, a user may receive an offer and request to join the contest through the wagering app 35210. For example, a user selects to join the contest on their wagering app 35210. The contest module 35228 may determine if the user meets the cohort requirements for the contest. For example, the contest module 35228 may filter the user database 35216 for the requesting user ID and extract the user's cohort number, such as one, to determine if that cohort number matches the cohort requirement for the contest. The cohort number provides users with the ability to compete in a contest with users of similar skill or expertise. If the user meets the cohort requirements for the contest, the contest module 35228 may allow the user to join the contest. For example, the user may receive a notification that they have been approved to join or have joined the contest. The contest module 35228 may store the user data in the contest database 35234. For example, the contest module 35228 may store a user ID, such as, JS123456, in the contest database 35234. If the user does not meet the cohort requirements for the contest, the contest module 35228 may deny the user's request to join the contest. For example, the user may receive a notification that says they have been rejected from joining or are not allowed to join the contest. The contest module 35228 may then determine if another user requests to join the contest. If another user requests to join the contest, the process may return to determining if the user meets the cohort requirements for the contest. If no other user requests to join the contest, the contest module 35228 may return to the base module 35224. The base module may initiate, at step 35304, the prize module 35230. For example, the prize module 35230 may begin with the base module 35224 initiating the prize module 35230. The prize module 35230 may continuously poll for the contest to end. For example, the contest may end at the finish of a live 35202 event such as the Boston Red Sox vs. New York Yankees game. In some embodiments, the contest may end at the finish of a series of live events 35202. In some embodiments, the contest may end after a certain time, such as hour, day or days, week or weeks, month or months, etc. The contest may then end for example, the contest may end at the finish of a live event 35202 such as the Boston Red Sox vs. New York Yankees game. In some embodiments, the contest may end at the finish of a series of live events 35202. In some embodiments, the contest may end after a certain time, such as hour, day or days, week or weeks, month or months, etc. The prize module 35230 may extract the first user ID from the contest database 35234. For example, the user ID JS123456 may be extracted from the contest database 35234. The prize module 35230 may filter the user database 35216 for the extracted user ID such as, JS123456, and filter the database for the user's wagering history. The prize module 35230 may filter the user database 35216 for the contest parameters such as, the live event 35202, series of live events 35202, time that the contest was active for, etc. . . . For example, if the contest was for the live event 35202, such as the Boston Red Sox vs. New York Yankees game on June 14th, the user database 35216 may be filtered for wagers that only occurred on June 14th, for the live event 35202, the Boston Red Sox vs. New York Yankees game. The same logic would apply if, for example, the contest was for all baseball events for the week of May 23rd through May 30th. The user database 35216 may be filtered for the baseball wagers from May 23rd to May 30th and the user's wagering history for the contest. The prize module 35230 may determine the total amount of wins for the user. For example, the user database 35216 may be filtered for the wagering history that applies to the contest. The prize module 35230 may count the user's wins. For example, if the user had won 21 wagers during the live event 35202, the Boston Red Sox vs. New York Yankees game, the 21 “wins” may be extracted. The prize module 35230 may store the total amount of wins for the user in the contest database 35234. For example, the prize module 35230 may store the 21 extracted “wins” in the contest database 35234 for the user ID JS123456. The prize module 35230 may determine if users remain in the contest database 35234. If so, the prize module 35230 may extract the next user ID and return to filter the user database 35216 for the extracted user ID. Info users remain in the contest database 35230, the prize module 35230 may sort the contest database 35234 for the most wins. For example, the prize module 35230 may sort the contest database 35234 for total number of wins by highest to lowest to determine which user won the contest. The prize module 35230 may extract the user ID with the most wins. For example, if the user ID JS123456 had the most wins at 21, it may be extracted from the contest database 35234. The prize module 35230 may send the prize, such as free credits, merchandise or swag, travel or vacation prizes, etc., to the extracted user ID with the most wins. For example, the prize module 35230 may send the user ID JS123456 a prize of $25 credits for winning the contest. The prize module 35230 may return to the base module 35224. The base module 35224 may then return to step 35300.

FIG. 354 illustrates the cohort module 35226. The process begins with the cohort module 35226 being initiated, at step 35400, by the base module 35224. The cohort module 35226 may extract, at step 35402, the first user wagering history in the user database 35216. For example, the cohort module 35226 may extract from the user database 35216 a user ID, device identifier, paired device identifier, wagering history, or wallet information for a user. The cohort module 35226 may compare, at step 35404, the extracted user wager history to the cohort database 35232. For example, if the user places ten wagers per week, the cohort module 35226 may compare this user to the cohort database 35232. The user may then be placed in cohort 1 since the requirement for cohort 1 is that a user places between 5 and 20 wagers a week. Another example may be if the user places 30 wagers a week, then the user may be placed in cohort 2 since the requirement for cohort 2 is that the user places between 21 and 49 wagers per week. The cohort module 35226 may extract, at step 35406, the corresponding cohort from the cohort database 35232. For example, the cohort module 35226 may extract the cohort number, such as 1, from the cohort database 35232. The cohort module 35226 may store, at step 35408, the extracted cohort in the user database 35216. For example, the cohort module 35226 may store cohort 1 in the user database 35216. The cohort module 35226 may determine, at step 35410, if users remain in the user database 35216. For example, the cohort module 35226 may go through each user in the user database 35216 and give a cohort to each user. If more users remain in the user database 35216, the cohort module 35226 may extract, at step 35412, the next user's wagering history from the user database 35216, and returns to step 35404. If no users remain in the user database 35216, the cohort module 35226 may returns at step 35414, to the base module 35224.

FIG. 355 illustrates the contest module 35228. The process begins with the base module 35224 initiating, at step 35500, the contest module 35228. The wagering network 35214 may create, at step 35502, the contest. For example, the wagering network 35214 may create a contest allowing users of the same cohort to participate against one another during a live event 35202, a series of live events 35202, live events 35202 for a certain time such as hour, day or days, week or weeks, month or months, etc. In some embodiments, the contest may be for users within a certain city, state, region, or other geographical requirements. In some embodiments, the contest may be for fans of certain teams, sports, etc. In some embodiments, a user may be able to invite other users to the contest. In some embodiments, the contest may be advertised with a prize such as free credits, merchandise or swag, travel or vacation prizes, etc. In some embodiments, the contest may have a certain number of players required to play or the maximum number of players allowed in the contest. In some embodiments, a user may receive an offer to join the contest through the wagering app 35210. A user may request, at step 35504, to join the contest. For example, the user may select to join the contest on their wagering app 35210. The contest module 35228 may determine, at step 35506, if the user meets the cohort requirements for the contest. For example, the contest module 35228 may filter the user database 35216 for the requesting user ID, extract the user's cohort number, such as one, and determine if that cohort number matches the cohort requirement for the contest. The cohort number may provide users with the ability to compete in a contest with users of similar skill or expertise. If the user meets the cohort requirements for the contest, the contest module 35228 may allow, at step 35508, the user to join the contest. For example, the user may receive a notification that informs them that they have been approved or have joined the contest. The contest module 35228 may store, at step 35510, the user data in the contest database 35234. For example, the contest module 35228 stores the user ID, such as JS123456, in the contest database 35234. If user does not meet the cohort requirements for the contest, the contest module 35228 may deny, at step 35512, the user's request to join the contest. For example, the user may receive a notification that says they are rejected from joining or are not allowed to join the contest. The contest module 35228 may determine, at step 35514, if another user requested to join the contest. If so, the contest module 35228 may return to step 35506. If no other user requests to join the contest, the contest module 35228 may return, at step 35516, to the base module 35224.

FIG. 356 illustrates the prize module 35230. The process begins with the base module 35224 initiating, at step 35600, the prize module 35230. The prize module 35230 may continuously poll, at step 35602, for the contest to end. For example, the contest may end at the finish of a live event 35202 such as the Boston Red Sox vs. New York Yankees game. In some embodiments, the contest may end at the finish of a series of live events 35202. In some embodiments, the contest may end after a certain time, such as hour, day or days, week or weeks, month or months, etc. The contest may end at step 35604. For example, the contest may end at the finish of a live event 35202 such as the Boston Red Sox vs. New York Yankees game. The prize module 35230 may extract, at step 35606, the first user ID from the contest database 35234. For example, the user ID JS123456 may be extracted from the contest database 35234. The prize module 35230 may filter, at step 35608, the user database 35216 for the extracted user ID. For example, the user database 35216 may be filtered for the user ID JS123456's wagering history. The prize module 135230 may filter, at step 35610, the user database 35216 for the contest parameters. For example, the user database 35216 may be filtered for parameters such as, the live event 35202, series of live events 35202, time that the contest was active for, etc. Further, if the contest was for the live event 35202, such as the Boston Red Sox vs. New York Yankees game on June 14th, the user database 35216 may be filtered for wagers that only occurred on June 14th, for that live event 35202, the Boston Red Sox vs. New York Yankees game. The same logic would apply if, for example, the contest was for all baseball events for the week of May 23rd through May 30th. The user database 35216 may be filtered for baseball wagers from May 23rd to May 30th and the user's wagering history for the contest. The prize module 35230 may determine, at step 35612, the user's total amount of wins. For example, the user database 35216 may be filtered for the wagering history that applies to the contest and the prize module 35230 may count each win for the user. Thus, if the user had won 21 wagers during the live event 35202, the Boston Red Sox vs. New York Yankees game, then the 21 “wins” may be extracted. The prize module 35230 may store, at step 35614, the user's total amount of wins in the contest database 35234. For example, the prize module 35230 may store the 21 extracted “wins” in the contest database 35234 for the user ID JS123456. The prize module 35230 may determine, at step 35616, if users remain in the contest database 35234. If so, the prize module 35230 may extract, at step 35618, the next user ID, and return to step 35608. If no users remain in the contest database 35230, the prize module 35230 may sort, at step 35620, the contest database 35234 for the most wins. For example, the prize module 35230 may sort the contest database 35234 for total number of wins by highest to lowest to determine which user won the contest. The prize module 35230 may extract, at step 35622, the user ID with the most wins. For example, if the user ID JS123456 had the most wins at 21, it may be extracted from the contest database 35234. The prize module 35230 may send, at step 35624, the prize to the extracted user ID. For example, the prize for the contest, such as free credits, merchandise or swag, travel or vacation prizes, etc., may be sent to the user ID with most wins. For example, the prize module 35230 may send the user ID JS123456 a prize of $25 credits for winning the contest. The prize module 35230 may return, at step 35626, to the base module 35224.

FIG. 357 illustrates the cohort database 35232. The cohort database 35232 may contain the cohort number, such as 1, 2, 3, etc. and the cohort's requirement to join for potential users, such as, the user places 5-20 wagers a week, the user places 21-49 wagers a week, or the user places 50 or more wagers a week. The cohort database 35232 may be used in the process described above for the cohort module 35226 to place users in cohorts representative of their skill level for the wagering app 35210. In some embodiments, the cohort database 35232 requirements may use historical wagering patterns for a day, week, month, year, etc. In some embodiments, the cohort database 35232 requirements may be based on monetary value, such as the more money spent by a user, the higher the cohort.

FIG. 358 illustrates the contest database 35234. The contest database 35234 may contain the user IDs for the users in the contest, such as JS123456, and the total amount of wins for the user, such as 21. The contest database 35234 may be used in the process described above for the contest module 35228 to store the user IDs for users included in the contest. Also, the contest database 35234 may be used in the process described above for the prize module 35230 to determine and store the total amount of wins for each user in the contest. In some embodiments, the contest database 35234 may include the contest parameters, such as, the live event 35202, the series of live events 35202, the live events 35202 for a certain time, such as hour, day or days, week or weeks, month or months, etc. In some embodiments, the contest database 35234 may include the geographical requirements for the contest, such as users within a certain city, state, region, or other geographical requirements. In some embodiments, the contest database 35234 may include the prize, such as, free credits, merchandise or swag, travel or vacation prizes, etc. In some embodiments, the contest database 35234 may include the minimum or the maximum number of entries for the contest and either the total number of entries for the contest or the total number of entries for each user.

FIG. 359 illustrates a system for in-play wagering for contest prizes by points, according to an embodiment.

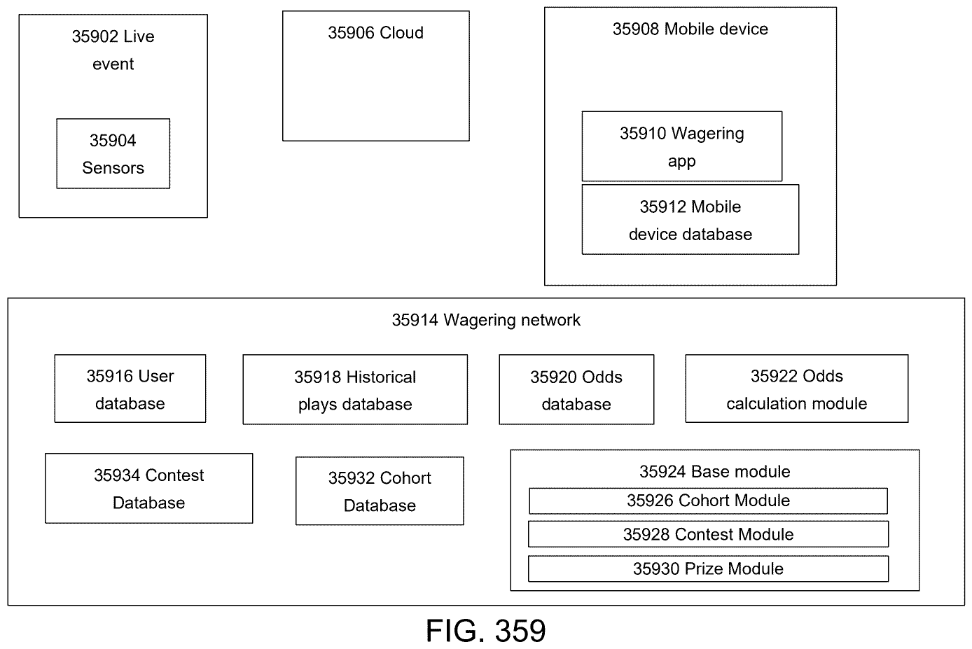

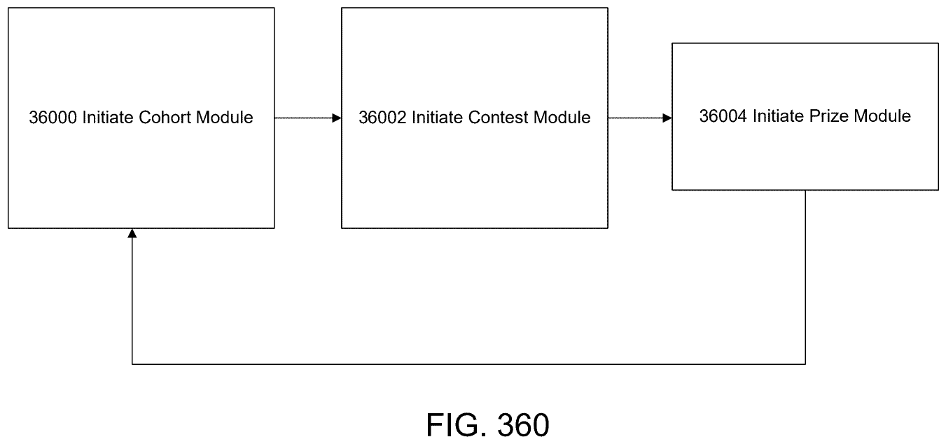

FIG. 360 illustrates a base module, according to an embodiment.

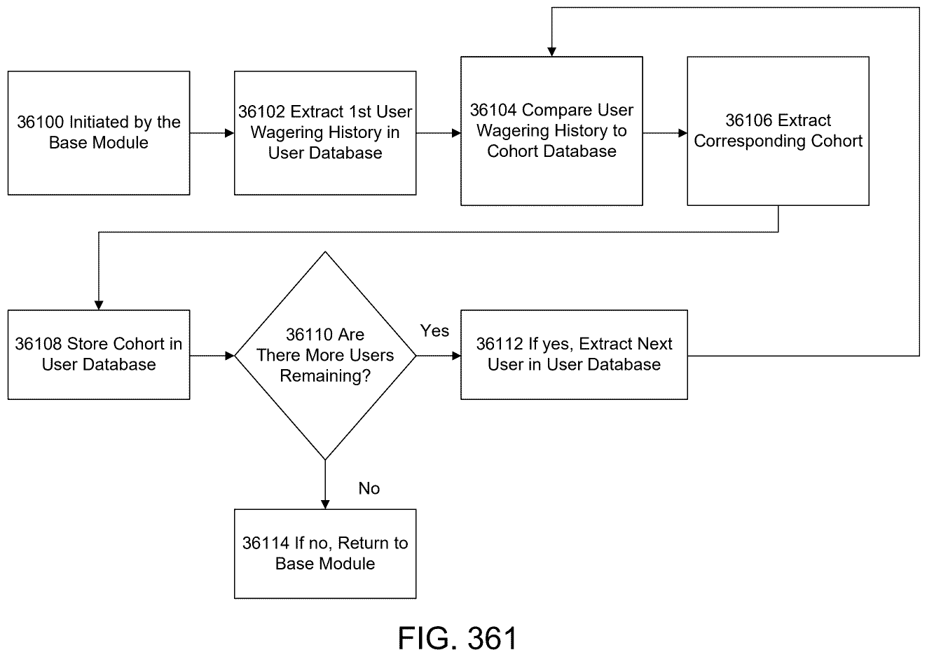

FIG. 361 illustrates a cohort module, according to an embodiment.

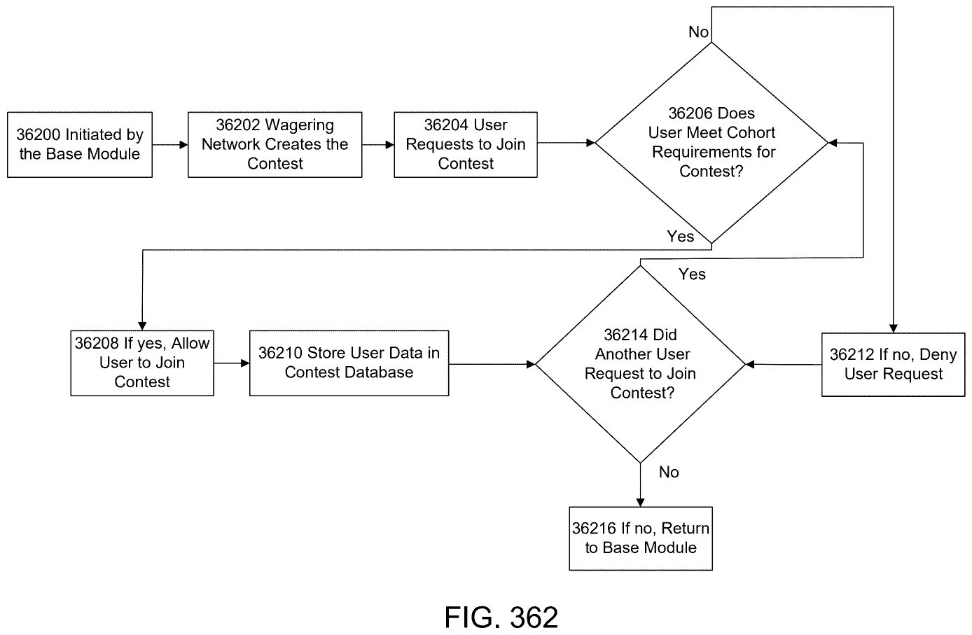

FIG. 362 illustrates a contest module, according to an embodiment.

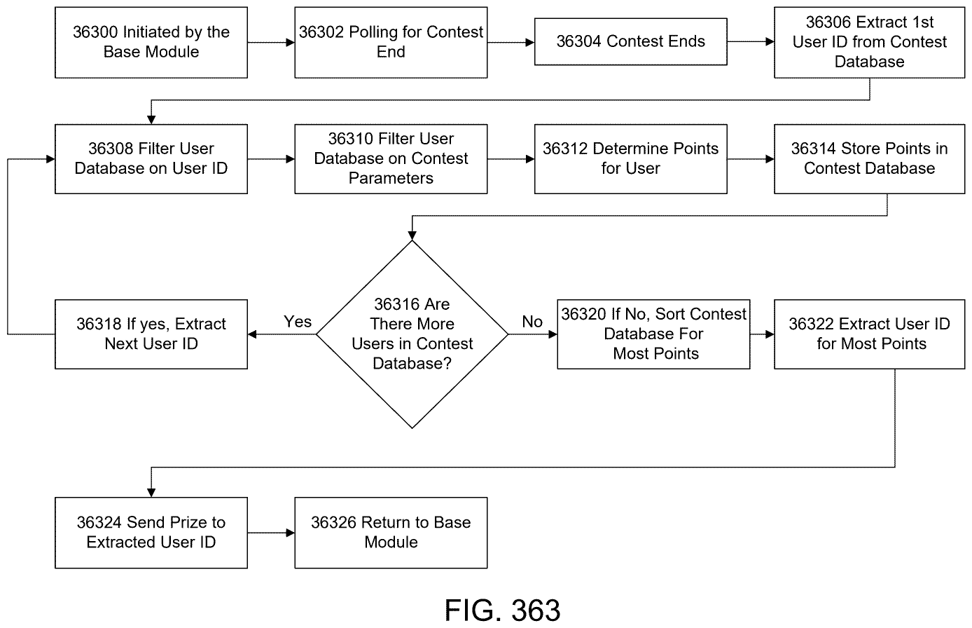

FIG. 363 illustrates a prize module, according to an embodiment.

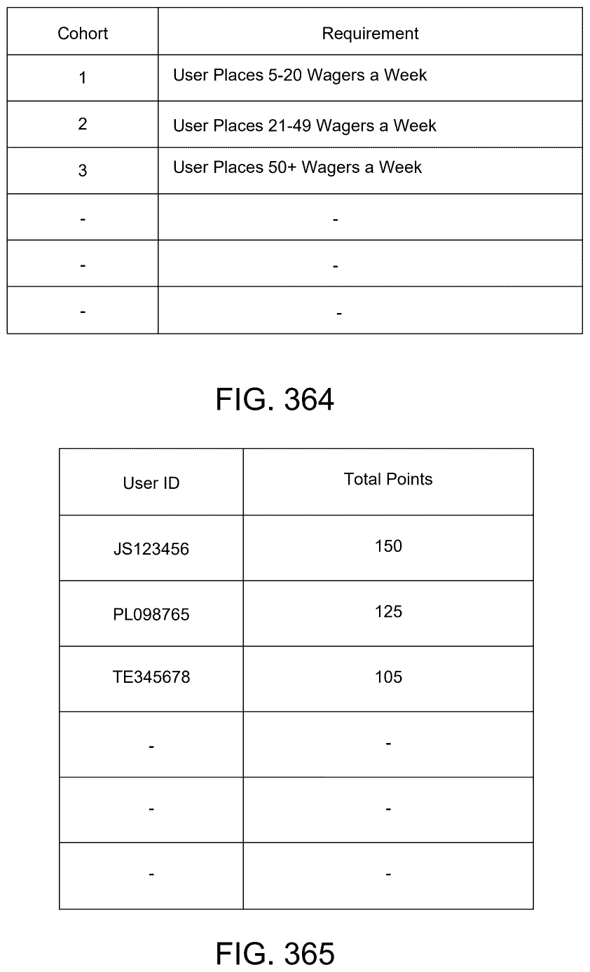

FIG. 364 illustrates a cohort database, according to an embodiment.

FIG. 365 illustrates a contest database, according to an embodiment.

FIG. 359 is a system for in-play wagering for contest prizes by points. This system may include a live event 35902, for example, a sporting event such as a football, basketball, baseball, or hockey game, tennis match, golf tournament, eSports or digital game, etc. The live event 35902 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, the underdog or longshot. Betting on all favorites is referred to as chalk and is typically applied to a round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 35902, such as the score of an American football game or the run line in a baseball game, or a series of actions in the live event 35902. Sportsbooks have several bets they can handle, limiting the amount of wagers they can take on either side of a bet before moving the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point, spreads to the middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers, which can be done at kiosks at the live event 35902 or another location.

Further, embodiments may include a plurality of sensors 35904 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 35904 may include but are not limited to, tracking devices, such as RFID tags, GPS chips, or other such devices embedded on uniforms, in equipment, in the field of play, and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 35906 or a communication network that may be a wired and a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expanding computer infrastructure and maintenance resources. Cloud 35906 may be communicatively coupled to a peer-to-peer wagering network 35914, which may perform real-time analysis on the type of play and the result of the play. Cloud 35906 may also be synchronized with game situational data such as the time of the game, the score, location on the field, weather conditions, and the like, which may affect the choice of play utilized. For example, in an exemplary embodiment, cloud 35906 may not receive data gathered from the sensors 35904 and may, instead, receive data from an alternative data feed, such as Sports Radar®. This data may be compiled substantially immediately following the completion of any play. They may be compared with a variety of team data and league data based on a variety of elements, including the current down, possession, score, time, team, and so forth, as described in various exemplary embodiments herein.

Further, embodiments may include a mobile device 35908 such as a computing device, laptop, smartphone, tablet, computer, smart speaker, or I/O devices. I/O devices may be present in the computing device. Input devices may include, but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple inputs or output devices such as Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 35908 could be an optional component and would be utilized in a situation where a paired wearable device employs the mobile device 35908 for additional memory or computing power or connection to the internet.

Further, embodiments may include a wagering software application or a wagering app 35910, which is a program that enables the user to place bets on individual plays in the live event 35902, streams audio and video from the live event 35902, and features the available wagers from the live event 35902 on the mobile device 35908. The wagering app 35910 allows users to interact with the wagering network 35914 to place bets and provide payment/receive funds based on wager outcomes.

Further, embodiments may include a mobile device database 35912 that may store some or all the user's data, the live event 35902, or the user's interaction with the wagering network 35914.

Further, embodiments may include the wagering network 35914, which may perform real-time analysis on the type of play and the result of a play or action. The wagering network 35914 (or the cloud 35906) may also be synchronized with game situational data, such as the time of the game, the score, location on the field, weather conditions, and the like, which may affect the choice of play utilized. For example, in an exemplary embodiment, the wagering network 35914 may not receive data gathered from the sensors 35904 and may, instead, receive data from an alternative data feed, such as SportsRadar®. This data may be provided substantially immediately following the completion of any play. They may be compared with a variety of team data and league data based on a variety of elements, including the current down, possession, score, time, team, and so forth, as described in various exemplary embodiments herein. The wagering network 35914 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 35916, which may contain data relevant to all users of the wagering network 35914 and may include, but is not limited to, a user ID, a device identifier, a paired device identifier, wagering history, or wallet information for the user. The user database 35916 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 35916 may contain betting lines and search queries. The user database 35916 may be searched based on a search criterion received from the user. Each betting line may include, but is not limited to, a plurality of betting attributes such as at least one of the following: the live event 35902, a team, a player, an amount of wager, etc. The user database 35916 may include but is not limited to information related to all the users involved in the live event 35902. In one exemplary embodiment, the user database 35916 may include information for generating a user authenticity report and a wagering verification report. Further, the user database 35916 may be used to store user statistics like, but not limited to, the retention period for a particular user, frequency of wagers placed by a particular user, the average amount of wager placed by each user, etc.

Further, embodiments may include a historical plays database 35918 that may contain play data for the type of sport being played in the live event 35902. For example, in American Football, for optimal odds calculation, the historical play data may include metadata about the historical plays, such as time, location, weather, previous plays, opponent, physiological data, etc.

Further, embodiments may utilize an odds database 35920 that contains the odds calculated by an odds calculation module 35922 to display the odds on the user's mobile device 35908 and take bets from the user through the mobile device wagering app 35910.

Further, embodiments may include the odds calculation module 35922, which utilizes historical play data to calculate odds for in-play wagers.

Further, embodiments may include a base module 35924, which initiates the cohort module 35926, the contest module 35928, and the prize module 35930.

Further, embodiments may include the cohort module 35926, which may be initiated by the base module 35924. The cohort module 35926 may extract the first user wagering history in the user database 35916. For example, the user database 35916 may contain the user ID, a device identifier, a paired device identifier, wagering history, or wallet information for the user. The cohort module 35926 may then compare the extracted user wager history to a cohort database 35932. For example, if the user places ten wagers per week, the user may be placed in cohort 1 since the requirement for cohort 1 is that a user places between 5 and 20 wagers a week. The cohort module 35926 may extract the corresponding cohort from the cohort database 35932. For example, cohort module 35926 may extract the cohort number, such as 1, from the cohort database 35932. The cohort module 35926 may then store the extracted cohort in the user database 35916. For example, cohort module 35926 may store cohort 1 in the user database 35916. The cohort module 35926 may then determine if more users remain in the user database 35916. For example, the cohort module 35926 may go through each user in the user database 35916 and give a cohort to each user. If there are additional users in the user database 35916, the cohort module 35926 may then extract the next user's wagering history from the user database 35916. The process may then return to comparing the wagering history with the cohort database 35932. If there are no remaining users in the user database 35916, the cohort module 35926 may then return to the base module 35924.

Further, embodiments may include the contest module 35928, which may begin with the base module 35924 initiating the contest module 35928. The wagering network 35914 may then create a contest. For example, the wagering network 35914 may create a contest allowing users of the same cohort to participate against one another during the live event 35902, a series of live events 35902, live events 35902 for a certain time such as hour, day or days, week or weeks, month or months, etc. In some embodiments, the contest may be for users within a certain city, state, region, or other geographical requirements. In some embodiments, the contest may be for fans of certain teams, sports, etc. In some embodiments, a user may be able to invite other users to the contest. In some embodiments, the contest may be advertised with a prize such as free credits, merchandise or swag, travel or vacation prizes, etc. In some embodiments, the contest may require a certain number of players play or a maximum number of players allowed in the contest. In some embodiments, a user may receive an offer to join the contest through the wagering app 35910. A user may request to join the contest on their wagering app 35910. The user may be approved if they meet the cohort requirements for the contest. For example, the contest module 35928 may filter the user database 35916 for the requesting user ID and extract the user's cohort number, such as 1, and determine if the cohort number matches the cohort requirement for the contest. The cohort number may allow users to compete in a contest with users of similar skill or expertise. If the user meets the cohort requirements for the contest, the contest module 35928 may then allow the user to join the contest. For example, the user may receive a notification that they have been approved or have joined the contest. The contest module 35928 may then store the user data in a contest database 35934. For example, contest module 35928 may store the user ID, such as JS123456, in the contest database 35934. If the user does not meet the cohort requirements for the contest, the contest module 35928 may then deny the user's request to join the contest. For example, the user may receive a notification that informs them that they were rejected from joining or are not allowed to join the contest. The contest module 35928 may then determine if another user has requested to join the contest. If another user requested to join the contest, then the process may return to check that the user meets the cohort requirements for the contest. If no other user requests to join the contest, the contest module 35928 may then return to the base module 35924.

Further, embodiments may include the prize module 35930, which is initiated by the base module 35924. The prize module 35930 may continuously poll for the contest to end. For example, a contest may end at the completion of a live event 35902 such as the Boston Red Sox vs. New York Yankees game. In some embodiments, the contest may end at the finish of a series of live events 35902. In some embodiments, the contest may end after a certain time, such as hour, day or days, week or weeks, month or months, etc. The contest may then end. The prize module 35930 may then extract the first user ID from the contest database 35934. For example, the user ID JS123456 may be extracted from the contest database 35934. The prize module 35930 may then filter the user database 35916 for the extracted user ID. For example, the user database 35916 may be filtered for the user ID JS123456's wagering history. The prize module 35930 may then filter the user database 35916 for the contest parameters. For example, the user database 35916 may be filtered for the live event 35902, series of live events 35902, time that the contest was active for, etc. Further, if the contest were for the live event 35902, such as the Boston Red Sox vs. New York Yankees game on June 14th, the user database 35916 may be filtered for wagers that only occurred on June 14th, for the Boston Red Sox vs. New York Yankees game. The same logic would apply if, for example, the contest was for all baseball events for the week of May 23rd through May 30th. The user database 35916 may be filtered for the baseball wagers from May 23rd to May 30th and the user's wagering history for the contest. The prize module 35930 may determine the user's total amount of points. For example, the user database 35916 may be filtered for the wagering history that applies to the contest allowing the prize module 35930 to count the user's points. For example, a user may earn points by selecting wagers with different odds, such as 1:1, 2:1, 3:1, etc., and is awarded the points if the wager is won. In another example, if the user selected that a batter would hit a home run during the current at-bat with 6:1 odds and the batter hits a home run, the user may be awarded 6 points. Further, if a user selected that a pitcher would throw a strike on the first pitch of an at-bat at 2:1 odds and the first pitch is a strike, then the user may be awarded 2 points. In some embodiments, the user may lose points for losing a selected wager. In some embodiments, the users may have a certain number of points to use during the contest, such as 100 points. In some embodiments, the user may wager a monetary value and receive a monetary value for winning the wager in addition to receiving points for the contest. The prize module 35930 may store the user's total amount of points in the contest database 35934. For example, the prize module 35930 may store the extracted 150 points in the contest database 35934 for the user with the ID JS123456. The prize module 35930 may determine if users remain in the contest database 35934. If so, the prize module 35930 may extract the next user ID, and may return to filtering the user database 35916 for the extracted user ID. If there are no remaining users in the contest database 35934, the prize module 35930 may sort the contest database 35934 for user ID with the most points. For example, the prize module 35930 may sort the contest database 35934 by total points from highest to the lowest amount to determine which user won the contest. The prize module 35930 may extract the user-ID with the most points. For example, if the user with the ID JS123456 had the most points at 150, the prize module 35930 may extract it from the contest database 35934. The prize module 35930 may send the prize to the extracted user ID. For example, the prize for the contest, such as free credits, merchandise or swag, travel or vacation prizes, etc., may be sent to the user-ID with the most points. For example, the prize module 35930 may send the user with the ID JS123456 the prize of $25 credits for winning the contest. The prize module 35930 may return to the base module 35924.

Further, embodiments may include the cohort database 35932, which may contain the cohort number, such as 1, 2, 3, etc. as well as the cohort's requirement for users to join, such as the user places 5-20 wagers a week, the user places 21-49 wagers a week, or the user places 50 or more wagers a week. The cohort database 35932 may be used in the process described above for the cohort module 35926 to place users in cohorts representative of their skill level for the wagering app 35910. In some embodiments, the cohort database 35932 requirements may use historical wagering patterns for a day, week, month, year, etc. In some embodiments, the cohort database 35932 requirements may be based on a monetary value, such as the more money spent by a user, the higher the cohort.

Further, embodiments may include the contest database 35934, which may contain the user IDs for the contest, such as JS123456, and the user's total amount of points, such as 150. The contest database 35934 may be used in the process described above for the contest module 35928 to store user IDs included in the contest and in the process described in the prize module 35930 to determine and store the total amount of points for each user in the contest. In some embodiments, the contest database 35934 may include the contest parameters such as the live event 35902, the series of live events 35902, the live events 35902 for a certain time such as hour, day or days, week or weeks, month or months, etc. In some embodiments, the contest database 35934 may include the geographical requirements for the contest, such as users within a certain city, state, region, or other geographical requirements. In some embodiments, the contest database 35934 may include the prize such as free credits, merchandise or swag, travel or vacation prizes, etc. In some embodiments, the contest database 35934 may include the minimum or the maximum number of entries for the contest and either the total number of entries for the contest or the total number of entries for each user.

FIG. 360 illustrates the base module 35924. The process may begin with the base module initiating, at step 36000, the cohort module 35926. For example, the cohort module 35926 may extract the first user wagering history from the user database 35916 which may contain the user ID, a device identifier, a paired device identifier, wagering history, or wallet information for the user. The cohort module 35926 may compare the extracted user wager history to cohort database 35932. For example, if the user places ten wagers per week, the user may be placed in cohort 1 since the requirement for cohort 1 is that a user places between 5 and 20 wagers a week. The cohort module 35926 may extract the corresponding cohort number. For example, the cohort module 35926 may extract the cohort number, such as cohort 1, from the cohort database 35932. The cohort module 35926 may store the extracted cohort number in the user database 35916. For example, the cohort module 35926 may store cohort 1 in the user database 35916. The cohort module 35926 may determine if users remain in the user database 35916. For example, the cohort module 35926 may go through each user in the user database 35916 and give a cohort number to each user. If users remain in the user database 35916, the cohort module 35926 may extract the next user's wagering history from the user database 35916. The process may return to comparing the wagering history with the cohort database 35932. If no users remain in the user database 35916, the cohort module 35926 may return to the base module 35924. The base module 35924 may initiate, at step 36002, the contest module 35928. For example, the wagering network 35914 may create a contest allowing users of the same cohort to participate against one another during a live event 35902, a series of live events 35902, live events 35902 for a certain time, such as hour, day or days, week or weeks, month or months, etc. In some embodiments, the contest may be for users within a certain city, state, region, or other geographical requirements. In some embodiments, the contest may be for fans of certain teams, sports, etc. In some embodiments, a user may be able to invite other users to the contest. In some embodiments, the contest may be advertised with a prize such as free credits, merchandise or swag, travel or vacation prizes, etc. In some embodiments, the contest may have a certain number of players required to play or the maximum number of players allowed in the contest. In some embodiments, a user may receive an offer to join the contest through the wagering app 35910. A user may request to join the contest. For example, the user may select to join the contest on their wagering app 35910. The contest module 35928 may determine if the user meets the cohort requirements for the contest. For example, the contest module 35928 may filter the user database 35916 for the requesting user's ID, extract the user's cohort number, such as 1, and determine if that cohort number matches the cohort requirement for the contest. The cohort number may allow users to compete in a contest with users of similar skill or expertise. If the user meets the cohort requirements for the contest, the contest module 35928 may allow the user to join the contest. For example, the user may receive a notification that they have been approved to join or have joined the contest. The contest module 35928 may store the user data in the contest database 35934. For example, the contest module 35928 may stores the user ID, such as JS123456, in the contest database 35934. If the user does not meet the cohort requirements for the contest, the contest module 35928 may deny the user's request to join the contest. For example, the user may receive a notification that says they have been rejected from joining or are not allowed to join the contest. The contest module 35928 may determine if another user has requested to join the contest. If so, the process may return to determining if the user meets the cohort requirements for the contest. If no other user requested to join the contest, the contest module 35928 may return to the base module 35924. The base module may initiate, at step 36004, the prize module 35930. For example, the prize module 35930 may be initiated by the base module 35924. The prize module 35930 may continuously poll for the contest to end. For example, the contest may end at the completion of a live event 35902 such as the Boston Red Sox vs. New York Yankees game. In some embodiments, the contest may end at the finish of a series of live events 35902. In some embodiments, the contest may end after a certain time, such as hour, day or days, week or weeks, month or months, etc. The contest may end. For example, the contest may end at the finish of a live event 35902 such as the Boston Red Sox vs. New York Yankees game. In some embodiments, the contest may end at the finish of a series of live events 35902. In some embodiments, the contest may end after a certain time, such as hour, day or days, week or weeks, month or months, etc. The prize module 35930 may extract the first user ID from the contest database 35934. For example, the prize module 35930 may extract the user ID JS123456 from the contest database 35934. The prize module 35930 may filter the user database 35916 for the extracted user ID. For example, the prize module 35930 may filer the user database 35916 for the user ID JS123456 and the user's wagering history. The prize module 35930 may filter the user database 35916 for the contest parameters. For example, the prize module 35930 may filter the user database 35916 for the live event 35902, series of live events 35902, time that the contest was active for, etc. For example, if the contest were for the live event 35902, such as the Boston Red Sox vs. New York Yankees game on June 14th, the user database 35916 may be filtered for wagers that only occurred on June 14th, for the live event 35902, the Boston Red Sox vs. New York Yankees game. The same logic would apply if, for example, the contest was for all baseball events for the week of May 23rd through May 30th. The user database 35916 may be filtered for baseball wagers from May 23rd to May 30th and the user's wagering history for the contest. The prize module 35930 may determine the total amount of points for the user. For example, the user database 35916 may be filtered for the wagering history that applies to the contest. The prize module 35930 may count each point earned by the user. For example, a user may earn points by selecting wagers with different odds, such as 1:1, 2:1, 3:1, etc., and is awarded the points if the wager is won. For example, if the user selected that a batter would hit a home run during the current at-bat at 6:1 odds and the batter hits a home run, the user may be awarded 6 points. Also if a user-selected that a pitcher would throw a strike on the first pitch of an at-bat at 2:1 odds and the first pitch is a strike, then the user may be awarded 2 points. In some embodiments, the user may lose points for losing a selected wager. In some embodiments, the users may have a certain number of points to use during the contest, such as 100 points. In some embodiments, the user may wager a monetary value and receive a monetary value for winning the wager in addition to receiving points for the contest. The prize module 35930 may store the total amount of points for the user in the contest database 35934. For example, the prize module 35930 may store the extracted points in the contest database 35934 for the user with the ID JS123456. The prize module 35930 may determine if users remain in the contest database 35934. If so, the prize module 35930 may extract the next user ID and return to filtering the user database 35916 for the extracted user ID. If no users remain in the contest database 35930, the prize module 35930 may sort the contest database 35934 for the most points. For example, the prize module 35930 may sort the contest database 35934 by total amount of points from highest to lowest to determine which user won the contest. The prize module 35930 may extract the user-ID with the most points. For example, the prize module 35930 may extract from the contest database 35934 the user ID JS123456 because it has the most points at 150. The prize module 35930 may send the prize to the extracted user ID. For example, the prize for the contest, such as free credits, merchandise or swag, travel or vacation prizes, etc., may be sent to the user-ID with the most points. For example, the prize module 35930 may send the user with the ID JS123456 the prize of $25 credits for winning the contest. The prize module 35930 may return to the base module 35924. The base module 35924 may then return to step 36000.

FIG. 361 illustrates the cohort module 35926. The process may begin with cohort module 35926 being initiated, at step 36100, by the base module 35924. The cohort module 35926 may extract, at step 36102, the first user's wagering history from the user database 35916 which may also contain the user ID, a device identifier, a paired device identifier, wagering history, or wallet information for the user. The cohort module 35926 may compare, at step 36104, the extracted user's wager history to the cohort database 35932. For example, if the user places ten wagers per week, the user may be placed in cohort 1 since the requirement for cohort 1 is that a user places between 5 and 20 wagers a week.

Another example may be if the user places 30 wagers a week, then the user may be placed in cohort 2 since the requirement for cohort 2 is that a user places between 21 and 49 wagers per week. The cohort module 35926 may extract, at step 36106, the corresponding cohort number from the cohort database 35932. For example, the cohort module 35926 may extract the cohort number, such as 1, from the cohort database 35932. The cohort module 35926 may store, at step 36108, the extracted cohort in the user database 35916. For example, the cohort module 35926 may store cohort 1 in the user database 35916. The cohort module 35926 may determine, at step 36110, if users remain in the user database 35916. For example, the cohort module 35926 may go through each user in the user database 35916 and give a cohort number to each user. If users remain in the user database 35916, the cohort module may extract, at step 36112, the next users wagering history in the user database 35916. The process may then return to step 36104. If no users remain in the user database 35916, the cohort module 35926 may return, at step 36114, to the base module 35924.

FIG. 362 illustrates the contest module 35928. The process may begin with the base module 35924 initiating, at step 36200, the contest module 35928. The wagering network 35914 may create, at step 36202, a contest. For example, the wagering network 35914 may create a contest allowing users of the same cohort to participate against one another during a live event 35902, a series of live events 35902, live events 35902 for a certain time such as hour, day or days, week or weeks, month or months, etc. In some embodiments, the contest may be for users within a certain city, state, region, or other geographical requirements. In some embodiments, the contest may be for fans of certain teams, sports, etc. In some embodiments, a user may be able to invite other users to the contest. In some embodiments, the contest may be advertised with a prize such as free credits, merchandise or swag, travel or vacation prizes, etc. In some embodiments, the contest may have a certain number of players required to play or list the maximum number of players allowed in the contest. In some embodiments, a user may receive an offer to join the contest through the wagering app 35910. A user may request, at step 36204, to join the contest on their wagering app 35910. The contest module 35928 may determine, at step 36206, if the user meets the cohort requirements for the contest. For example, the contest module 35928 may filter the user database 35916 for the requesting user ID and extract the user's cohort number, such as 1, and determine if the cohort number matches the cohort requirement for the contest. The cohort number may allow users to compete in a contest with users of similar skill or expertise. If the user does not meet the cohort requirements for the contest, the contest module 35928 may skip to step 36212. If the user meets the cohort requirements for the contest, the contest module 35928 may allow, at step 36208, the user to join the contest. For example, the user may receive a notification that they have been approved to join or have joined the contest. The contest module 35928 may store, at step 36210, the user's data in the contest database 35934. For example, contest module 35928 may store the user ID, such as JS123456, in the contest database 35934. If the user does not meet the cohort requirements for the contest, the contest module 35928 may deny, at step 36212, the user's request to join the contest. For example, the user may receive a notification that they have been rejected from joining or not allowed to join the contest. The contest module 35928 may determine, at step 36214, if another user requested to join the contest. If so, the process may return to step 36206. If no other user requested to join the contest, the contest module 35928 may return, at step 36216, to the base module 35924.

FIG. 363 illustrates the prize module 35930. The process may begin with the base module 35924 initiating, at step 36300, the prize module 35930. The prize module 35930 may continuous poll, at step 36302, for the contest to end. For example, the contest may end at the finish of a live event 35902 such as the Boston Red Sox vs. New York Yankees game. In some embodiments, the contest may end at the finish of a series of live events 35902. In some embodiments, the contest may end after a certain time, such as hour, day or days, week or weeks, month or months, etc. The contest may end at step 36304. For example, the contest may end at the finish of a live event 35902 such as the Boston Red Sox vs. New York Yankees game. In some embodiments, the contest may end at the finish of a series of live events 35902. In some embodiments, the contest may end after a certain time, such as hour, day or days, week or weeks, month or months, etc. The prize module 35930 may extract, at step 36306, the first user ID from the contest database 35934. For example, the prize module 35930 may extract the user ID JS123456 from the contest database 35934. The prize module 35930 may filter, at step 36308, the user database 35916 for the extracted user ID. For example, the prize module 35930 may filter the user database 35916 for the user ID JS123456 and the user's wagering history. The prize module 35930 may filter, at step 36310, the user database 35916 for the contest parameters, such as, the live event 35902, series of live events 35902, time that the contest was active for, etc. For example, if the contest were for one live event 35902, such as the Boston Red Sox vs. New York Yankees game on June 14th, the user database 35916 may be filtered for wagers that only occurred on June 14th, for that live event 35902, the Boston Red Sox vs. New York Yankees game. The same logic would apply if, for example, the contest was for all baseball events for the week of May 23rd through May 30th. The user database 35916 may be filtered for the baseball wagers from May 23rd to May 30th and the user's wagering history for the contest. The prize module 35930 may determine, at step 36312, the user's total amount of points. For example, the prize module 35930 may filter the user database 35916 for the wagering history that applies to the contest. The prize module 35930 may count each point earned by the user. For example, a user may earn points by selecting wagers with different odds, such as 1:1, 2:1, 3:1, etc., and is awarded the points if the wager is won. Further, if the user selected that a batter would hit a home run during the current at-bat at 6:1 odds and the batter hits a home run, the user may be awarded 6 points. Also, if a user-selected that a pitcher would throw a strike on the first pitch of an at-bat at 2:1 odds and the first pitch is a strike, then the user may be awarded 2 points. In some embodiments, the user may lose points for losing a selected wager. In some embodiments, the user may be provided a certain number of initial points to use during the contest, such as 100 points. In some embodiments, the user may wager a monetary value and receive a monetary value for winning the wager in addition to receiving points for the contest. The prize module 35930 may store, at step 36314, the user's total amount of points in the contest database 35934. For example, the prize module 35930 may store the extracted 150 points in the contest database 35934 for the user with the ID JS123456. The prize module 35930 may determine, at step 36316, if more users remain in the contest database 35934. If so, the prize module may extract, at step 36318, the next user ID, and the process may return to step 36308. If no users remain in the contest database 35930, the prize module 35930 may sort, at step 36320, the contest database 35934 for the most points. For example, the prize module 35930 may sort the contest database 35934 by total points from highest to lowest to determine which user won the contest. The prize module 35930 may extract, at step 36322, the user ID with the most points. For example, the prize module 35930 may extract the user with the ID JS123456 who has the most points, at 150, from the contest database 35934. The prize module 35930 may send, at step 36324, the prize, such as free credits, merchandise or swag, travel or vacation prizes, etc., to the user-ID with the most points. For example, the prize module 35930 may send the user with the ID JS123456 the prize of $25 credits for winning the contest. The prize module 35930 returns, at step 36326, to the base module 35924.

FIG. 364 illustrates cohort database 35932. The cohort database 35932 may contain the cohort number, such as cohort 1, cohort 2, cohort 3, etc. and the cohort's requirement to join for potential users, such as, the user places 5-20 wagers a week, the user places 21-49 wagers a week, or the user places 50 or more wagers a week. The cohort database 35932 may be used in the process described above for the cohort module 35926 to place users in cohorts representative of their skill level for the wagering app 35910. In some embodiments, the cohort database 35932 requirements may use historical wagering patterns for a day, week, month, year, etc. In some embodiments, the cohort database 35932 requirements may be based on monetary value, such as the more money spent by a user, the higher the cohort.

FIG. 365 illustrates the contest database 35934. The contest database 35934 may contain the user IDs for the users in the contest, such as JS123456, and the total amount of points for the user, such as 150. The contest database 35934 may be used in the process described above for the contest module 35928 to store the user IDs for users included in the contest. Also, the contest database 35934 may be used in the process described above for the prize module 35930 to determine and store the total amount of points for each user in the contest. In some embodiments, the contest database 35934 may include the contest parameters such as the live event 35902, the series of live events 35902, the live events 35902 for certain times such as hour, day or days, week or weeks, month or months, etc. In some embodiments, the contest database 35934 may include the geographical requirements for the contest, such as users within a certain city, state, region, or other geographical requirements. In some embodiments, the contest database 35934 may include the prize such as free credits, merchandise or swag, travel or vacation prizes, etc. In some embodiments, the contest database 35934 may include the minimum or the maximum number of entries for the contest and either the total number of entries for the contest or the total number of entries for each user.

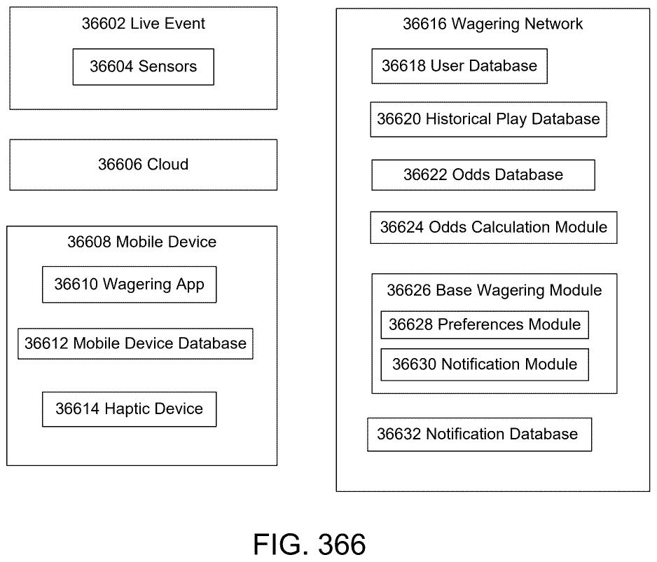

FIG. 366 illustrates a system for haptic wager notification, according to an embodiment.

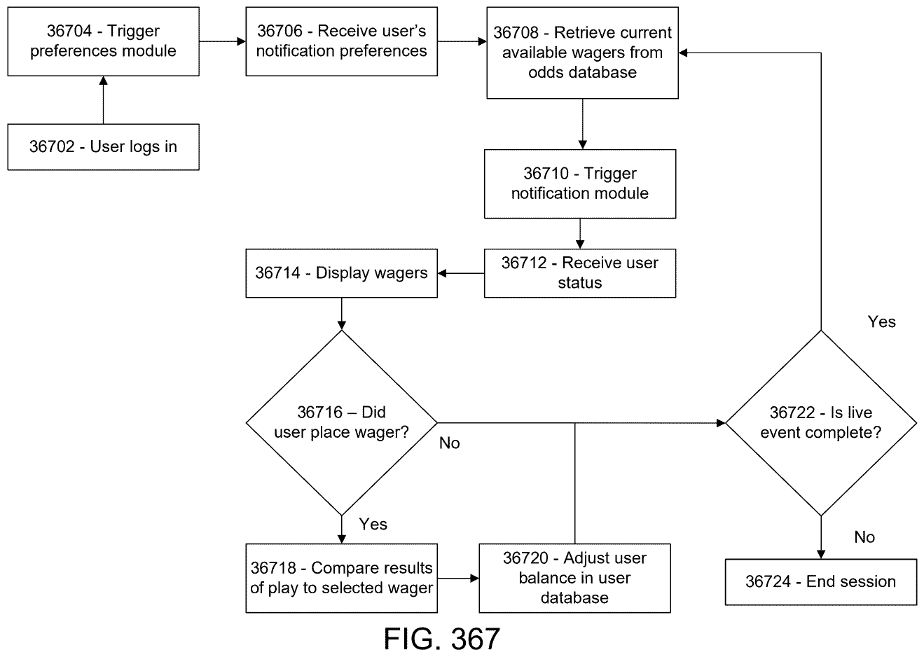

FIG. 367 illustrates a base wagering module, according to an embodiment.

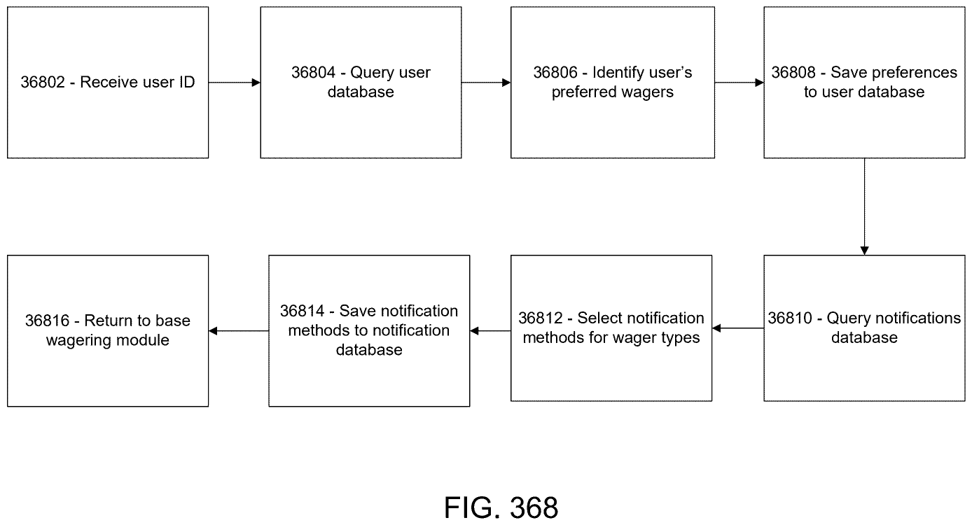

FIG. 368 illustrates a preferences module, according to an embodiment.

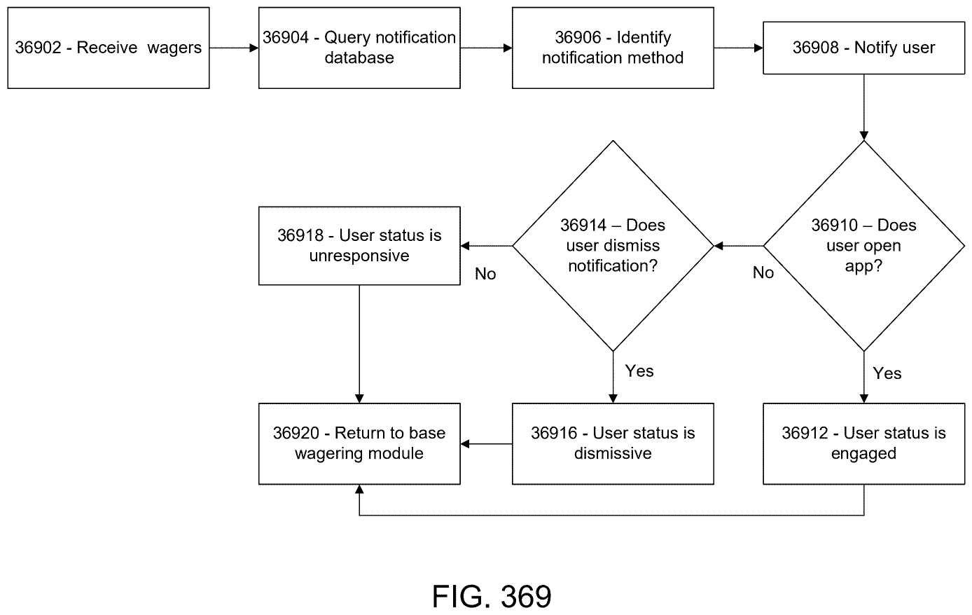

FIG. 369 illustrates a notification module, according to an embodiment.

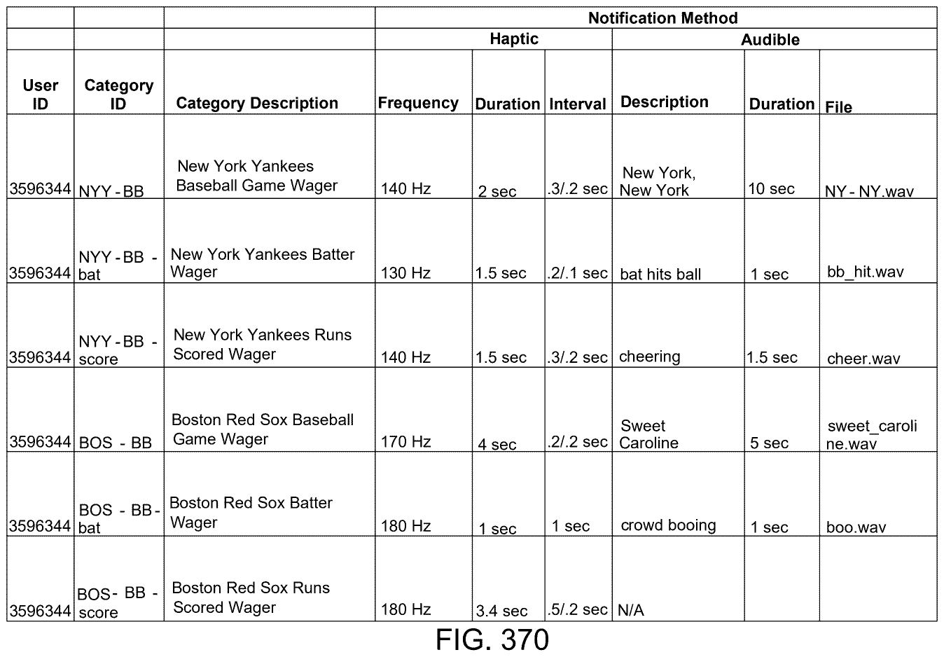

FIG. 370 illustrates a notification database, according to an embodiment.

FIG. 366 is a system for haptic wager notification. This system may include a live event 36602, for example, a sporting event such as a football, basketball, baseball, or hockey game, tennis match, golf tournament, eSports, or digital game, etc. The live event 36602 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 36602, such as the score of an American football game or the run line in a baseball game, or a series of actions in the live event 36602. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 36602 or at another location.

Further, embodiments may include a plurality of sensors 36604 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 36604 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 36606 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 36606 may be communicatively coupled to a peer-to-peer wagering network 36614, which may perform real-time analysis on the type of play and the result of the play. The cloud 36606 may also be synchronized with game situational data such as the time of the game, the score, location on the field, weather conditions, and the like, which may affect the choice of play utilized. For example, in an exemplary embodiment, the cloud 36606 may not receive data gathered from the sensors 36604 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 36608 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 36608 could be an optional component and would be utilized in a situation where a paired wearable device employs the mobile device 36608 for additional memory or computing power or connection to the internet.

Further, embodiments may include a wagering software application or a wagering app 36610, which is a program that enables the user to place bets on individual plays in the live event 36602, streams audio and video from the live event 36602, and features the available wagers from the live event 36602 on the mobile device 36608. The wagering app 36610 may allow the user to interact with the wagering network 36616 to place bets and provide payment/receive funds based on wager outcomes.

Further, embodiments may include a mobile device database 36612 that may store some or all the user's data, the live event 36602, or the user's interaction with the wagering network 36616.

Further, embodiments may include a haptic device 36614, which may provide a physical vibration or movement intended to be felt by a person. A haptic device 36614 may be a vibrotactile device comprised of a rotating or oscillating mass with a variable frequency, duration, and interval between activations. A haptic device 36614 may alternatively be an ultrasonic device capable of creating a pressure wave near an object's surface, creating a sensation that a person near the object can feel. A haptic device 36614 may also use microfluidics, such that air can be forced through ports in a wearable device, such as a smartwatch or clothing worn by a user, which can create localized regions of pressure resulting in a haptic sensation. A haptic device 36614 may further be a force control device in a mechanism such as a button, lever, joystick, or other control devices such that the mechanism's resistance may be varied to provide sensation, typically as a form of feedback to the user of the mechanism. Alternatively, a haptic device 36614 may be a surface haptic device that can modulate a surface's texture to create tactile effects such as varying the amount of friction provided by the surface or physical features that may arise from the surface. Finally, a haptic device 36614 may be a component of a mobile device 36608 or a wearable device to provide haptic notifications or tactile feedback when using a touchscreen. The haptic device 36614 may alternatively be a standalone device or integrated into objects such as a stylus, pen, article of clothing, etc.

Further, embodiments may include the wagering network 36616, which may perform real-time analysis on the type of play and the result of a play or action. The wagering network 36616 (or the cloud 36606) may also be synchronized with game situational data, such as the time of the game, the score, location on the field, weather conditions, and the like, which may affect the choice of play utilized. For example, in an exemplary embodiment, the wagering network 36616 may not receive data gathered from the sensors 36604 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 36616 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 36618, which may contain data relevant to all users of the wagering network 36616 and may include, but is not limited to, a user ID, a device identifier, a paired device identifier, wagering history, or wallet information for the user. The user database 36618 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 36618 may contain betting lines and search queries. The user database 36618 may be searched based on a search criterion received from the user. Each betting line may include, but is not limited to, a plurality of betting attributes such as at least one of the live event 36602, a team, a player, an amount of wager, etc. The user database 36618 may include but is not limited to information related to all the users involved in the live event 36602. In one exemplary embodiment, the user database 36618 may include information for generating a user authenticity report and a wagering verification report. Further, the user database 36618 may be used to store user statistics like, but not limited to, the retention period for a particular user, frequency of wagers placed by a particular user, the average amount of wager placed by each user, etc.

Further, embodiments may include a historical plays database 36620 that may contain play data for the type of sport being played in the live event 36602. For example, in American Football, for optimal odds calculation, the historical play data may include metadata about the historical plays, such as time, location, weather, previous plays, opponent, physiological data, etc.

Further, embodiments may utilize an odds database 36622—that may contain the odds calculated by an odds calculation module 36624—to display the odds on the user's mobile device 108 and take bets from the user through the mobile device wagering app 36610.

Further, embodiments may include the odds calculation module 36624, which may utilize historical play data to calculate odds for in-play wagers.

Further, embodiments may include a base wagering module 36626 which may allow a user to log in and configure their notification preferences—which may used to provide haptic and audio notifications to the user when a wager becomes available—matching the user's preferences while the user may be not interacting with the wagering app 36610. The user's notification preferences may be manually set by the user or may be determined based upon the user's previous wagering history. The base wagering module 36626 may further utilize a notification module 36630 to determine a user's notification preferences.

Further, embodiments may include a preferences module 36628, which may query a user database 36618 and a notification database 36632 and prompt a user for input to determine the user's notification preferences, comprising the types of wagers and odds for which the user would like to receive notifications, and further determining customized notification to be provided to the user when such wagers are available. The notifications may include a haptic component and an audible component. If the user does not provide a preference, a default setting may alternatively be selected.

Further, embodiments may include a notification module 36630, which may query a notification database 36632 for the proper notification to be sent to a user to inform them that a wager may be available. The notification comprising a haptic component may additionally include an audible component. The notification module 36630 may further monitor the user's interaction with the mobile device 36608 and determine the user's status, such as whether the user is engaged, dismissive, or unresponsive.

Further, embodiments may include a notification database 36632 which may comprise one or more notification categories or lists. A notification category comprised of one or more wagering parameters such as type of live event 36602, type of wager, parties involved including an athletics team or a specific player, a specific situation such as field goal attempts during American football games or two outs during a baseball game. The notification categories may additionally comprise a list of users, or bettors, who have been identified as likely to place a wager on a wager described by the notification category's identifying wager criteria. The notification database 36632 may further include a default notification method, including a specific haptic pattern or audio notification. The haptic pattern or audio notification may be unique, representing the specific category, or may otherwise be distinguishable from at least one other haptic pattern or audio notification representing a different category.

FIG. 367 illustrates the “Base Wagering Module.” The process may begin with the user logging in, at step 36702, to the wagering app 36610. The user may log in with a username and a password. The username may comprise an email address or a string of alphanumeric characters or symbols chosen by the user or generated randomly. Similarly, the password comprising alphanumeric characters or symbols may be chosen by the user or generated randomly. Alternatively, the user logging in using a password manager, which may store the username and password, may allow for using a universal password or PIN number, or biometrics including fingerprint, facial recognition, or iris scanning to authenticate the user, and log into the wagering app 36610. The base wagering module 36626 may trigger, at step 36704, the preferences module 36628 which may provide the user's identifying information, such as a user ID or account number, to the preferences module 36628, retrieving the user's historical wagering data from the user database 36618 and prompting the user for wager preferences. The preferences module 36628 may further query the notification database 36632 for default notifications and prompt the user for their notification preferences for each of the identified wagers preferred by the user. In an embodiment, the user ID for a user, John Smith, may be 3596344. The base wagering module 36626 may receive, at step 36706, the user's notification preferences from the preferences module 36628. The notification preferences may be for the user John Smith comprising baseball games, especially those where the New York Yankees are competing and wagers involving batters, such as whether a batter will strike out or get a base hit or hit a home run, earn an RBI, etc. The notification preferences may additionally include the user Joe Smith's preferences for notifications for wagers where the New York Yankees are competing may be a haptic notification comprising activation of the mobile device's 36608 haptic device 36614 with five rapid pulses of 0.2 seconds with an interval of 0.1 second between pulses accompanied by the sound of a bat striking a ball unless the mobile device's volume is muted. The notification may alternatively or additionally be provided via a wearable device such as a smartwatch. The base wagering module 36626 may retrieve, at step 36708, the currently available wagers on the live event from the odds database 36622 matching the user's notification preferences as identified by the preferences module 36628. The odds may be calculated by the odds calculation module 36624 and comprise a win condition and odds, which may be represented as a payout ratio, such as 5:1 where a person wagering $10 would receive $50 for a successful outcome. In an embodiment, the user John Smith's notification preferences including baseball games, specifically games where the New York Yankees are competing. Additionally, the user, John Smith's notification preferences, may comprise wagers on base hits. In an alternate embodiment, the user John Smith's notification preferences include wagers on American football games but do not include baseball games. In a further embodiment, an exemplary wager during a baseball game between the New York Yankees and the Boston Red Sox may be that the next batter will get a base hit at odds of 3:1. The wager may additionally include a default wager amount such as $50. The base wagering module 36626 may trigger, at step 36710, the notification module 36630 with the available wagers. The notification module 36630 may use the notification preferences stored in the notification database 36632 to identify the appropriate notification method and notify the user via the user's mobile device 36608 or a wearable device. Identifying the appropriate notification method may include prioritizing the notification based upon the user's preferences to increase the likelihood of a positive response, resulting in a wager being placed. The notification module 36630 may further notify the user with the identified notification method and determine the user's status based upon whether the user opens the app, dismisses the notification without opening the app, or does nothing and returns the user's status to the base wagering module 36626. In an embodiment, the available wagers may include a wager that the next batter during a baseball game between the New York Yankees and the Boston Red Sox will get a base hit at odds of 3:1 and the user's notification preferences including a wager involving a batter during a baseball game where the New York Yankees are competing. The base wagering module 36626 may receive, at step 36712, a user status from the notification module 36630. The user status may be engaged if the user responds positively to the notification, dismissive if the user responds negatively to the notification, such as dismissing or silencing the notification, or unresponsive if the user fails to respond to the notification within a period. In an embodiment, the user John Smith may be determined to be engaged as he opened the wagering app 36610 in response to the notification. In an alternate embodiment, the user John Smith may be determined to be dismissive if he dismissed the notification or silenced future notifications from the current live event 36602. In a further embodiment, the user John Smith may be determined to be unresponsive if he does not respond to the notification before the opportunity to place a wager has passed. Alternatively, John Smith may be unresponsive if a predetermined period of five minutes has passed since the notification was provided. The base wagering module 36626 may display, at step 36714, the available wagers to the user via the wagering app 36610 on the mobile device 36608. The wagers may comprise at least a win condition and the odds being offered. The wagers, may include at least the wager related to the user's preferences which were used to identify the notification which was sent to the user. Similarly, the wagers displayed to the user may be related to the user preference related to the notification method used to notify the user. The wagers may additionally provide a default wager amount and a means of incrementing the wager amount or entering a custom wager amount. The wagers may additionally include a timer indicating the amount of time remaining during which a wager may be placed. In an embodiment, the wager may be that the next batter during a baseball game between the New York Yankees and the Boston Red Sox will get a base hit at odds of 3:1. The wager further may include a timer indicating that the user John Smith has 90 seconds remaining to place a wager. The base wagering module 36626 may receive, at step 36716, a wager from the user. The wager may comprise a wager amount that the win condition will occur at the specified odds such that the odds represent the multiple to be applied to the wager amount to determine the payout provided the user wins the wager. In an embodiment, the user John Smith may place a wager for $50 that the next batter will get a base hit at odds of 3:1. Alternatively, the user may not place a wager by either selecting an option to pass on placing a wager or allowing the opportunity period during which the user can place a wager to elapse. In an embodiment, the user John Smith may allow the opportunity period to elapse without placing a wager. The base wagering module 36626 may compare, at step 36718, the results of the play during the live event 36602 to the win condition of the selected wager to determine whether the user won the wager. In an embodiment, the next batter may have struck out and did not get a base hit; therefore, the user John Smith did not win the wager. In an alternate embodiment, the next batter may have hit a double and therefore got a base hit, in which case the user John Smith won the wager. The base wagering module 36626 may adjust, in step 36720, the user's account balance according to the results of the wager. If the user lost the wager, the wager amount may be deducted from the user's account. Alternatively, if the user won the wager, the payout amount may be determined by multiplying the wager amount by the odds. The payout amount may then be added to the user's account balance. In an embodiment, the user John Smith may have lost the wager, and therefore the wager amount of $50 may be deducted from his initial account balance of $1200, resulting in a new account balance of $1150. In an alternate embodiment, the user John Smith may have won the wager, and a payout of $150, determined by multiplying the wager amount of $50 by the odds of 3:1, may be added to the initial account balance of $1200, resulting in a new account balance of $1350. The base wagering module 36626 may determine, at step 36722, whether the live event 36602 may be complete. The live event 36602 may be complete if it has concluded, such as the end of elapsed playtime during a sporting event. In an embodiment, a baseball game may be concluded after the third out of the top of the 9th inning if the home team is leading, after the third out of the top of the 9th inning if the away team is leading, or if the home team scores a winning run in the bottom of the 9th inning. A baseball game may additionally conclude in an inning beyond the 9th inning if the 9th inning concludes in a tie. If the live event 36602 is not complete, returning to step 36708 and retrieving currently available wag ers from the odds database 36622. The base wagering module 36626 may end, at step 36724, the session if the live event 36602 is complete.

FIG. 368 illustrates the “Preferences Module.” The process may begin with the preferences module 36628 receiving, at step 36802, a user ID from the base wagering module 36626. The user ID may be associated with a user and their user account. In an embodiment, the user ID may be 3596344 and may be associated with a user, John Smith. The preferences module 36628 may query, at step 36804, the user database 36618 for details associated with the user such as the user's previous wagers and wager preferences such as the types of live events 36602, athletic teams, players, types of wagers, or odds on which the user prefers to place wagers. The wager information may additionally include geolocation data, such as locations where the user has previously placed wagers or the location of live events 36602 and the proximity of the live event 36602 wagered upon to the user. The user database 36618 may additionally store contextual information about the user's wagers, such as wagers that were also placed by the users' friends and wagers placed as part of a parlay or as a hedge against another wager. The contextual information may also include whether a wager resulted from a challenge by a friend or a wagering app 36610. The user database 36618 may additionally include the wager amount and results of the wagers. In an embodiment, a previous wager placed by the user John Smith including a wager of $100, that Aaron Judge would hit a home run in an at-bat at odds of 10:1. The wager may further include the results that Aaron Judge hit a home run in the designated at-bat resulting in a $1000 payout. The preferences module 36628 may identify, at step 36806, the user's preferred wagers based on the user's wager history retrieved from the user database 36618. The preferred wagers may include a type of wager which may be distinguished by any of the types of live event 36602, athletic team, player, type of wager, or odds involved in the wager and are additionally wagered upon by the user at a significantly higher rate than other wagers, such as more than double the average wager. Alternatively, the preferred wagers may be determined by ranking the types of wagers by the total number of wagers placed by the user and selecting a predetermined number of the results, such as the top 5 wagers. In an embodiment, the user John Smith may be determined to prefer placing wagers on batters, such as whether they will get a base hit, strikeout, earn an RBI, etc., during an at-bat. The user's preferred wagers may additionally include contextual bets, such as parlaying or hedging a second bet with a first bet or placing a wager in response to a friend placing a wager or receiving a challenge from a friend to place a particular wager. Such contextual wagers may be determined to be a preferred type of wager if they represent a significant portion of the user's overall wagering activity or if the user meets or exceeds a predetermined threshold value representing the percentage of wagers placed to the number of total opportunities within a particular context. For example, if the user John Smith places a wager 60% of the time in response to the user John Smith's friend, Jane Doe, placing the same wager before John Smith, it may be determined that placing a wager in response to a friend's wager, especially his friend, Jane Doe, may be a preferred wager type for user John Smith as it exceeds a predetermined threshold value of 50%. Additionally, the user may manually provide preferences via a wagering app 36610. The user's preferred wagers may additionally consider the user status in response to notifications such that wagers are more preferred if the user is engaged in response to notifications for that type of wager and less preferred if the user status is dismissive or unresponsive in response to a notification for a type of wager. The preferences module 36628 may save, at step 36808, the user's wager preferences to the user database 36618. The user's wager preferences may comprise the types of wagers the user most frequently chooses to place wagers upon or the types of wagers the user has chosen as their preferred types of wagers via manually defined preference settings. In an embodiment, updating the user database 36618 with the user John Smith's most preferred wagers on the outcome of a baseball player at bat, such as whether the player will get a base hit, strikeout, earn an RBI, etc. Additionally, saving the user John Smith's preferences to receive notifications for wagers during baseball games in which the New York Yankees are competing. The preferences module 36628 may query, at step 36810, the notification's database 36632 for available notifications which may be used by the wagering app 36610 to provide notifications to the user via a mobile device 36608, wearable device, or other devices in communication with the mobile device 36608 or wagering app 36610 such as a headset, speaker, etc. The available notifications may include compatibility with the mobile device 36608, wearable device, etc., being used by the user. Additionally, the available notifications may include haptic device 36614 patterns or sounds associated with default notification methods for a particular type of wager. In an embodiment, the notification database 36632, may include a default haptic pattern for available wagers where the New York Yankees are competing, which may be a haptic notification comprising activation of the mobile device's 36608 haptic device 36614 with three pulses of 0.4 seconds with an interval of 0.3 seconds between pulses accompanied by a segment of the song, New York, New York, unless the mobile device's volume is muted. The notification may alternatively or additionally be provided via a wearable device such as a smartwatch or clothing, including a haptic device 36614. The notification database 36632 may further store user-defined notification methods that may supersede default notifications, which may be used for contextual wagering opportunities, such as when a user's friend places a wager. The preferences module 36628 may select, at step 36812, notification methods for wager types matching the user's wager preferences. For example, a user Joc Smith's wager preferences include placing wagers on New York Yankee's batters, which may be paired with a notification comprising the sound of a bat hitting a ball and a haptic pattern of 130 Hz pulsing for 1.5 seconds with a pulse duration of 0.2 seconds and an interval of 0.1 seconds. Alternatively, the haptic device may be configured to deliver a haptic sensation mimicking the feeling of hitting a ball with a bat. In alternate embodiments, subscribing the user to a notification list such that the notification list contains all users who will be notified when the conditions defined by their wager preferences are met, resulting in them receiving a specified notification. In an embodiment, user Joe Smith may be subscribed to the New York Yankee's notification list such that when a wager may be available on a New York Yankee's game, the users subscribed to the list may receive a notification comprising a ten-second clip of the song, New York, New York accompanied by a two-second haptic notification pulsing with a frequency of 140 Hz for 0.3 seconds with an interval of 0.2 seconds. Notification methods may additionally be paired with other notification events, such as indicating the result of a play or a wager. In an embodiment, the user Joe Smith placing a wager on Aaron Rodgers getting a base hit in his next at-bat and receiving a notification comprised of the sound of a bat hitting a ball and a haptic sensation mimicking the feeling of a bat hitting a ball if the wager may be successful. Alternatively, the user Joe Smith may receive audio playback of an umpire calling the batter “out” if the wager was unsuccessful, which may optionally include a haptic component such as pulsing three times. The preferences module 36628 may save, at step 36814, the notification methods to the notification database 36632. The notification methods may include the default notifications methods for a wager or may include notification methods that the user has customized. In an embodiment, saving the user John Smith's notification method for wagers where the New York Yankees are competing in a baseball game with activation of the mobile device's 36608 haptic device 36614 with five rapid pulses of 0.2 seconds with an interval of 0.1 seconds between pulses and the sound of a crowd cheering, instead of the default notification method. The preferences module 36628 may return, at step 36816, to the base wagering module 36626 with the user's notification preferences. In an embodiment, the notification preferences for a user John Smith, including receiving notifications for wagers during baseball games in which the New York Yankees are competing involving the outcome of a baseball player's at-bat, such as whether the player will get a base hit, strikeout, earn an RBI, etc. The notification preferences may further comprise a notification method chosen by the user John Smith comprising activation of the mobile device's 36608 haptic device 36614 with five rapid pulses of 0.2 seconds with an interval of 0.1 seconds between pulses or a sound accompanying the haptic notification of a bat striking a ball.

FIG. 369 illustrates the “Notification Module.” The process may begin with the notification module 36630 receiving, at step 36902, wagers and associated notification preferences for a user. In an embodiment, the wagers may include that the next batter during a baseball game between the New York Yankees and the Boston Red Sox, Aaron Judge, will get a base hit at odds of 3:1 and the notification preferences for the user John Smith including a wager involving a batter during a baseball game where the New York Yankees are competing. The notification module 36630 may query, at step 36904, the notification database 36632 for the user's preferred notification methods. The user's preferred notification methods may comprise default haptics and sounds, customized haptics and sounds, or a combination of default and customized haptics and sounds. Haptics comprising the activation of at least one haptic device, such as an oscillating mass creating vibrations within a mobile device 36608 or a wearable device. Additionally, the notification methods may include audio, like music, a synthesized voice, or sound effects. In an embodiment, a notification method comprising a pulsing haptic device 36614 in a mobile device and playing a sound effect of an air horn blast. The notification module 36630 may identify, at step 36906, the notification method to be used to notify the user. The notification method may be chosen based upon the user's notification preferences, cither prioritizing the user's manually defined prioritization preferences, such as preferring to receive a notification that the wager relates to the New York Yankees rather than a baseball game, or that a wager relates to their preferred player, Aaron Judge, instead of the type of live event 36602 or the team participating in the live event 36602. Alternatively, the notification method selected may be related to the most frequently placed wagers. For example, if a user, John Smith, placed wagers on 20% of opportunities to wager on the New York Yankees but wagered on 50% of opportunities to wager on Aaron Judge, then the higher frequency wager type, on Aaron Judge, would take priority and the notification related to wagers involving Aaron Judge would be used. Alternatively, the notification priority may be related to the wager amount, such as the wager type upon which the user typically wagers more money. The wager amount may include the total wager amount, average wager amount, maximum wager amount, etc. Notification methods may further be prioritized by context, such as always prioritizing notification methods related to wagers placed by a friend or where a friend has issued a challenge to the user to place a specific wager. Multiple notification methods may alternatively be used together, such as using the haptic notification from a first notification method and the audio notification from a second notification method or by using a selection of notification methods in sequence, such as playing an air horn, which may be the notification method defined by user John Smith indicating a challenge by a friend, immediately followed by New York, New York with an accompanying haptic notification with the haptic device 36614 of the mobile device 36608 synchronized with the beat of the song to indicate the wager relates to the New York Yankees. The notification module 36630 may notify, at step 36908, the user using the identified notification method. The notification method may comprise at least one haptic component and optionally including an audio component. In an embodiment, the user John Smith's mobile device 36608 vibrating five times with each pulse of vibrations lasting. 2 seconds with an interval of 0.1 seconds between each pulse and additionally using the speakers on the mobile device 36608 to play the sound of a bat striking a ball to notify the user that a wager may be available on a baseball play involving a batter. The notification module 36630 may determine, at step 36910, whether the user opens the wagering app 36610 in response to the notification. The user may open the wagering app 36610 via a visual notification provided on the display of a mobile device 36608, using a verbal command to a digital assistant, or navigating to the wagering app 36610 via the mobile device's 36608 home screen. In an embodiment, the user John Smith opens the wagering app 36610 by tapping on a notification on the screen of a mobile device 36608. The notification module 36630 may determine, at step 36912, whether the user is engaged by determining if they expressed a positive reaction to the notification by opening the wagering app 36610 and saving the engaged user status to the user database 36618. In an embodiment, the user John Smith's user status may be determined to be engaged as he opened the wagering app 36610. In further embodiments, the user may need to open the wagering app 36610 within a predefined period to have a user status of engaged, such as five minutes from when the notification was provided or before the opportunity to place a wager on the selected wager has elapsed. The notification module 36630 may determine, at step 36914, whether the user dismissed the notification. The user dismissed the notification if they chose to clear the notification from their mobile device 36608 without opening the wagering app 36610. Alternatively, the user may open the wagering app 36610 and silence further notifications during the current live event 36602. In an embodiment, the user John Smith cleared the visual notification from the mobile device 36608 without opening the wagering app 36610. The notification module 36630 may determine, at step 36916, if the user is dismissive because they cleared the notification from their mobile device 36608 without opening the wagering app 36610 or silencing further notifications during the live event 36602 and saving the dismissive user status to the user database 36618. In an embodiment, the user John Smith has a user status of dismissive because he opened the wagering app and selected an option to silence all further notifications during the current live event 36602. The notification module 36630 may determine, at step 36918, if the user is unresponsive if the user does not interact with the mobile device 36602 or the notification provided to the user within a predetermined period and saving the unresponsive user status to the user database 36618. In an embodiment, the user John Smith may be determined to be unresponsive because he did not interact with the mobile device 36608 within five minutes of the notification being provided. In an alternate embodiment, the user John Smith interacting with the mobile device, however not interacting with the wagering app 36610 or the provided notification. The notification module 36630 may returning, at step 36920, to the base wagering module 36626 with the user status. The user status may be engaged, dismissive, unresponsive, etc. In an embodiment, returning the base wagering module 36626 may mean that the user John Smith is engaged.

FIG. 370 illustrates the “Notification Database.” The notification database 36632 may store notification methods for different wager types. The wager types can be categorized based on at least one defining characteristic of the wager, such as the type of live event 36602, the teams or players competing in the live event 36602 or participating in a play for which a wager may be offered, or the type of play the wager describes. Additionally, the defining characteristic may relate to the odds being offered as well as the context of the wager, such as whether the user's friend has placed a wager or whether the wager is the subject of a challenge issued by a friend, another user, or a wagering app 36610. The notification methods associated with each wager type may be configured by the administrator of a wagering network 36616 or may otherwise be customized by a user via a wagering app 36610. The notification methods may involve a haptic component and an audible component. The notification database 36632 may be populated by the administrator of a wagering network 36616 or the preferences module 36630 and may be used by the preferences module 36628 and the notification module 36630. Customizations by the preferences module 36628 may include the creation of new haptic and audio effects or the modification of an existing haptic or audio effect including any of the type of haptic effect, its magnitude, duration, etc. and similarly the selection, volume, duration, etc. of the audio component. The haptic component may include any vibrotactile haptics, ultrasonic mid-air haptics, microfluidics, force control haptics, or surface haptics. It may be utilized to simulate a recognizable physical sensation, such as the feeling of hitting a bat with a ball, catching a ball in a glove, kicking a football, hitting a ball with a tennis racket, etc. Alternatively, the haptic component may not simulate a physical sensation but instead be identifiable compared to other haptic elements used for other notification methods. The audio component may be any sound effect, voice recording, an audio clip from an audio or video recording, or at least part of a musical composition. For example, a sound effect may include the sound of a bat hitting a ball, of a ball being caught by a glove, of helmets clashing at the line of scrimmage during an American football game, or a golf club hitting a golf ball. Voice recordings may be prerecorded, such as an umpire at a baseball game calling a player “out,” or may be custom recordings by the user of a wagering app 36610. Audio clips could be recognizable segments from a previous live event 36602, including broadcasts by sports announcers, commentators, or news persons related to a previous live event 36602. Music may be closely associated with athletic teams participating in a live event 36602, such as New York, New York sung by Frank Sinatra, which the New York Yankees typically play after home game victories or Sweet Caroline sung by Neil Diamond, which may be played during the seventh-inning stretch at Boston Red Sox home games at Fenway Park, or Chelsea Dagger by the Fratelli's which may be a frequent theme song for the Chicago Blackhawks. Songs may be associated due to them regularly being played in the teams' respective home stadiums, ballparks, arenas, etc., or the songs may be composed for or mention a team or performed by an artist closely affiliated with an artist athletic team's home city. Such songs may be used as the audio component of a notification method for wagers for the team with which the songs relate, such as playing New York, New York for a wager being offered on a game or play involving the New York Yankees, or Sweet Caroline for the Boston Red Sox. The haptic component may complement the audio component by matching the beat or rhythm of a song. For example, a wager on a play during a hockey game may be indicated by the sound of ice skates that a referee's whistle may accompany, or the sound of a dribbling basketball could indicate a play on a basketball game squeaking of shoes sliding on a basketball court. A user may record a taunt to send to a friend and used as a notification when a friend places a wager or friend issues a challenge to the user. The notification methods may be used in combination, such as playing the sound of a bat hitting a ball and the sensation of a bat hitting a ball created by a haptic device 36614 to indicate the wager relates to a play involving a batter which may be immediately followed by a segment of New York, New York indicating the wager also involves the New York Yankees. Similarly, a unique sound effect may be chosen to represent multiple characteristics of a wager, such as the P.C. Richards & Son “whistle” which the New York Yankees use during home games, which may be used to represent a wager on a New York Yankees pitcher. A haptic representation of the rhythm may accompany the sound effect, or the notification method may be comprised solely by the haptic representation of the rhythm without the accompanying audio.

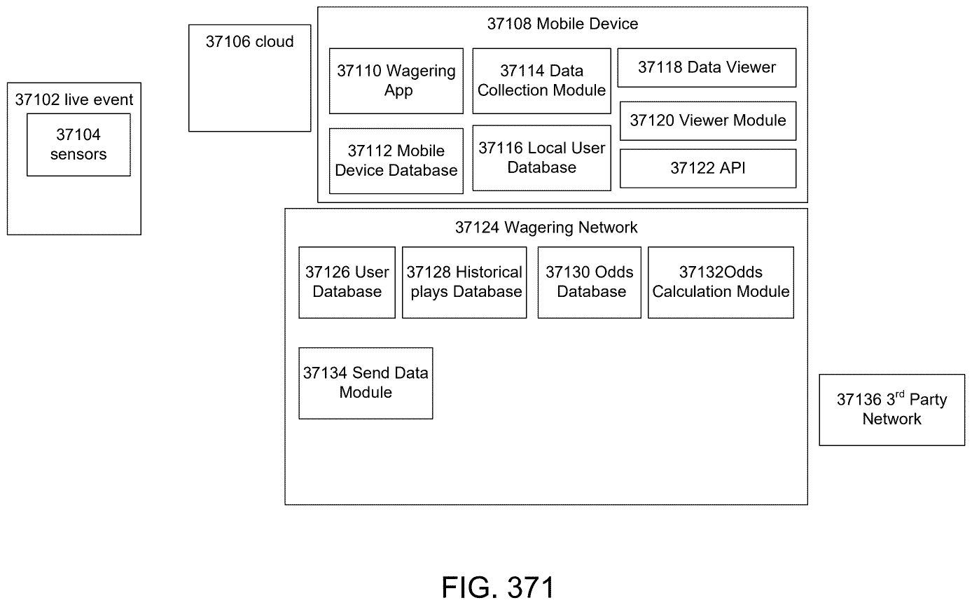

FIG. 371 illustrates a method for storing wagering data locally, according to an embodiment.

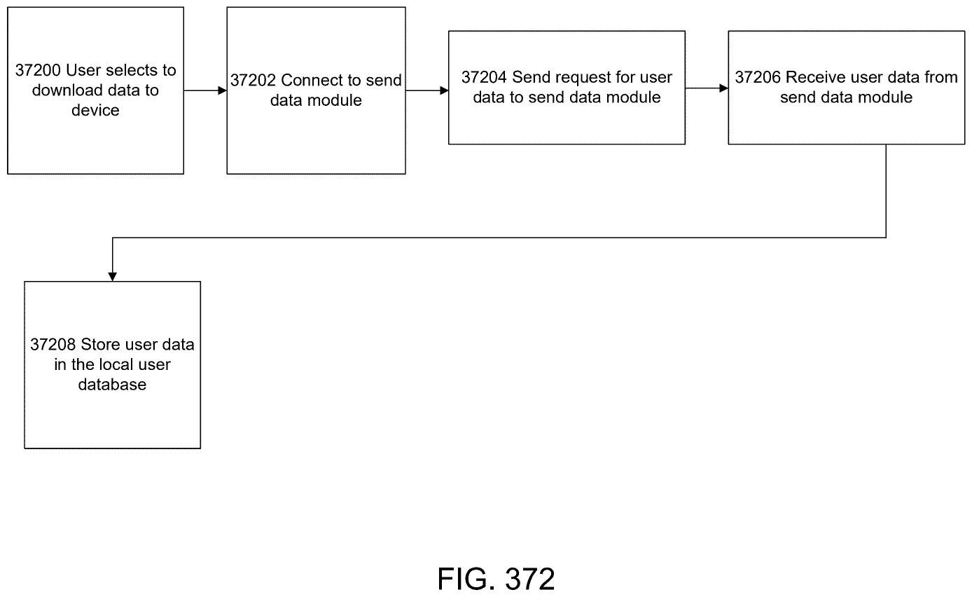

FIG. 372 illustrates a data collection module, according to an embodiment.

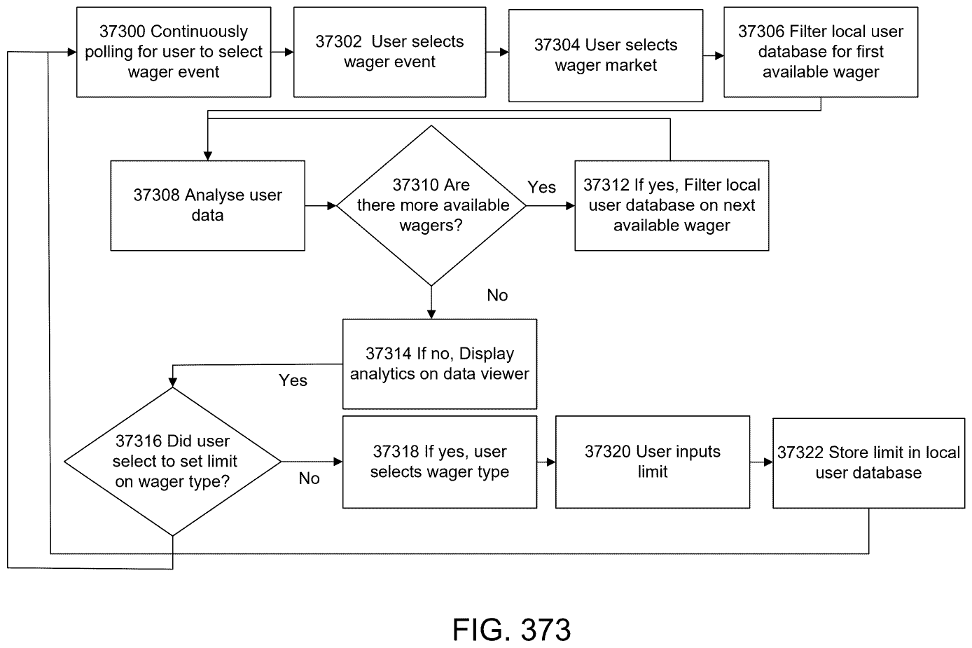

FIG. 373 illustrates a viewer module, according to an embodiment.

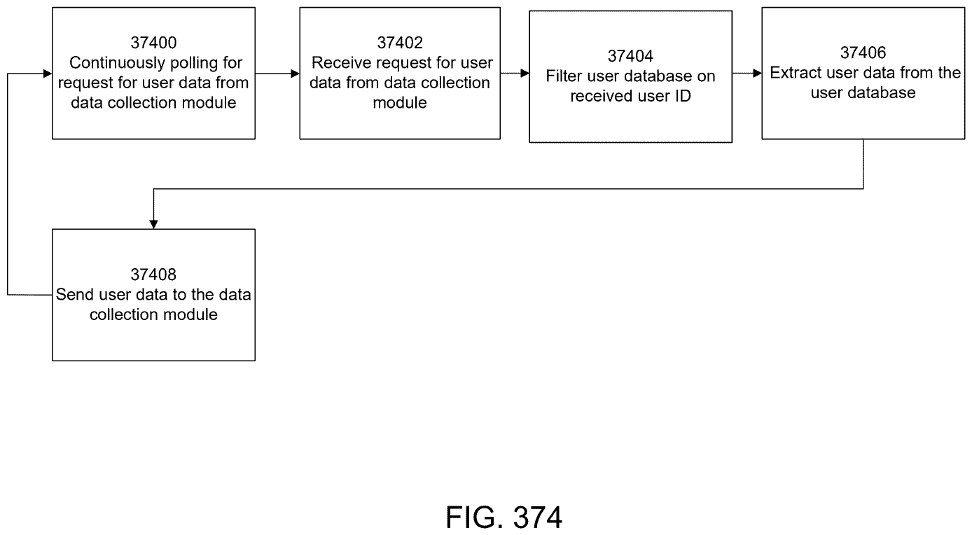

FIG. 374 illustrates a send data module, according to an embodiment.

FIG. 371 is a method for storing wagering data locally. This system may include a live event 37102, for example, a sporting event such as a football, basketball, baseball, or hockey game, tennis match, golf tournament, eSports, or digital game, etc. The live event 37102 may include some number of actions or plays upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 37102, such as the score of an American football game or the run line in a baseball game, or a series of actions in the live event 37102. Sportsbooks have several bets they can handle, limiting the number of wagers they can take on either side of a bet before moving the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers, which can be done at kiosks at the live event 37102 or at another location.

Further, embodiments may include a plurality of sensors 37104 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 37104 may include but are not limited to, tracking devices, such as RFID tags, GPS chips, or other such devices embedded on uniforms, in equipment, in the field of play, and boundaries of the field of play, or on other markers in the field of play. In addition, imaging devices may also be used as tracking devices, such as player tracking, which provide statistical information through real-time X, Y positioning of players and X, Y, Z positioning of the ball.

Further, embodiments may include a cloud 37106 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 37106 may be communicatively coupled to a peer-to-peer wagering network 37124, which may perform real-time analysis on the type of play and the result of the play. The cloud 37106 may also be synchronized with game situational data such as the time of the game, the score, location on the field, weather conditions, and the like, which may affect the choice of play utilized. For example, in an exemplary embodiment, the cloud 37106 may not receive data gathered from the sensors 37104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 37108 such as a computing device, laptop, smartphone, tablet, computer, smart speaker, or I/O devices. I/O devices may be present in the computing device. Input devices may include but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple input or output devices such as Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 108 could be an optional component and may be utilized in a situation where a paired wearable device employs the mobile device 37108 for additional memory or computing power or connection to the internet.

Further, embodiments may include a wagering software application or a wagering app 37110, which is a program that enables the user to place bets on individual plays in the live event 37102, streams audio and video from the live event 37102, and features the available wagers from the live event 37102 on the mobile device 37108. The wagering app 37110 allows the user to interact with the wagering network 37124 to place bets and provide payment/receive funds based on wager outcomes.

Further, embodiments may include a mobile device database 37112 that may store some or all the user's data, the live event 37102, or the user's interaction with the wagering network 37124.

Further, embodiments may include a data collection module 37114, which may begin with the user selecting to download the user's data to the device. For example, there may be an option in the wagering app 37110 to allow users to request to download their data, such as a user ID, a device identifier, a paired device identifier, wagering history, or wallet information. Also, the user data may include user interests, user personal details, such as age, mobile number, etc., previously played sporting events, highest wager, favorite sporting event, or current user balance and standings. Then the data collection module 37114 may connect to the send data module 37134. The data collection module 37114 may send a request for the user data to the send data module 37134. For example, the data collection module 37114 may send a request for the user data, such as a user ID, a device identifier, a paired device identifier, wagering history, or wallet information. Also, the data may include user interests, user personal details such as age, mobile number, etc., previously played sporting events, highest wager, favorite sporting event, or current user balance and standings. The data collection module 37114 may receive the user data from the send data module 37134. For example, the data collection module 37114 may receive the user data, such as a user ID, a device identifier, a paired device identifier, wagering history, or wallet information for the user. Also, the data may include user interests, user personal details such as age, mobile number, etc., previously played sporting events, highest wager, favorite sporting event, or current user balance and standings. Then the data collection module 37114 may store the user data in a local user database 37116. For example, the data stored in the local user database 37116 may be a user ID, a device identifier, a paired device identifier, wagering history, or wallet information for the user. Also, the data may include user interests, user personal details such as age, mobile number, etc., previously played sporting events, highest wager, favorite sporting event, or current user balance and standings.

Further, embodiments may include the local user database 37116, that may contain a user ID, a device identifier, a paired device identifier, wagering history, or wallet information for the user. Also, the data may include user interests, user personal details such as age, mobile number, etc., previously played sporting events, highest wager, favorite sporting event, or current user balance and standings. The local user database 37116 may also contain the monetary limit that a user can wager on a specific wager and the wager type.

Further, embodiments may include a data viewer 37118, which may be a GUI or guided user interface in which the user can access, analyze, manipulate, etc. the data stored in the local user database 37116 to find trends, strengths, weaknesses, etc. within their wagering history to perform better and with more efficiency.

Further, embodiments may include a viewer module 37120, which may begin with the viewer module 37120 continuously polling for the user to select a wager event. For example, the user may select the Boston Red Sox vs. the New York Yankees event. Then the user may select a wager event. For example, the user may select the Boston Red Sox vs. the New York Yankees event. The user may select a wagering market. For example, the user may select the wagering market for the results of the J. D. Martinez at-bat in the first inning in the Boston Red Sox vs. the New York Yankees event. Then the viewer module 37120 may filter the local user database 37116 for the first available wager. For example, the viewer module 120 may filter the local user database 37116 for the previous wagering results for when the user wagered on the outcome of an at-bat, which has multiple wager options such as the batter will hit a single, double, triple, home run, strikeout, walk, fly out, ground out, line out, etc. In some embodiments, the database may be filtered on the outcome of an at-bat involving a specific player or team. In some embodiments, the database may be filtered on the type of wager the user has selected, such as play-by-play wagers, for example, the result of an at-bat, pitch, baserunner, etc. In some embodiments, the database may be filtered for other sports, such as basketball, football, hockey, soccer, etc. The viewer module 37120 may analyze the user data from the filtered local user database 37116. For example, the viewer module 37120 may analyze the filtered database by further filtering the database based on the wager options such as single, double, triple, etc. and for each wager option determine the number of total bets a user has made and divide the number by the total amount of wins the user has achieved to determine the user's winning percentage on the type of wager, such as if the user has wagered 20 times on the results of an at-bat being a single and has won 5 times wagering on the result of an at-bat being a single then the user's wagering percentage may be 25%. The viewer module 37120 may determine if there are additional available wagers. For example, the user's winning percentage for the wagering on the result to be a single may be 25%. Still, there may be other wagering options available to the user such as double, triple, home run, strikeout, walk, fly out, ground out, line out, etc. and the next available wager, such as a double, may be selected and the local user database 37116 may be filtered on the result being a double. If there are more available wagers, then the viewer module 37120 may filter the local user database 37116 for the next available wager. For example, the user's winning percentage for the wagering on the result to be a single may be 25%. Still, there may be other wagering options available to the user such as double, triple, home run, strikeout, walk, fly out, ground out, line out, etc. and the next available wager, such as a double, may be selected and the local user database 37116 may be filtered on the result being a double. If there are no more available wagers, then the viewer module may display the analytics on the data viewer 37118. For example, the viewer module 37120 may display the user's winning percentage for all available wagers, such as 25% for a single, 35% for a double, etc. The viewer module 37120 may determine if the user selected to set a limit on a wager type. If the user did not select to set a limit on a wager type, then the process may return to continuously polling for the user to select a wager event. If the user selected to set a limit, then the user may select the wager type. For example, the user may select to set a limit on the amount of money they can wager on a specific wager once they see their winning percentage, so the user may desire to set a limit of $10 on wagering for the at-bat result to be a single since their winning percentage is only 25%. Then the user may input the limit. For example, the user may input a limit for the amount of money they can wager on a specific wager, such as a $10 limit on wagering for the at-bat result to be a single since their winning percentage is only 25%. 320. The viewer module 37120 may store the limit and the wager type in the local user database 37116. For example, the data stored may be the monetary limit that a user can wager on a specific wager and the wager type to prevent the user from wagering too much money on the specific wager type.

Further, embodiments may include an API 37122, which may be a set of functions and procedures allowing the creation of applications that access the features or data of the local user database 37116 on the mobile device 37108.

Further, embodiments may include the wagering network 37124, which may perform real-time analysis on the type of play and the result of a play or action. The wagering network 37124 (or the cloud 37106) may also be synchronized with game situational data, such as the time of the game, the score, location on the field, weather conditions, and the like, which may affect the choice of play utilized. For example, in an exemplary embodiment, the wagering network 37124 may not receive data gathered from the sensors 37104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 37124 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 37126, which may contain data relevant to all users of the wagering network 37124 and may include, but is not limited to, a user ID, a device identifier, a paired device identifier, wagering history, or wallet information for the user. The user database 37126 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 37126 may contain betting lines and search queries. The user database 37126 may be searched based on a search criterion received from the user. Each betting line may include, but is not limited to, a plurality of betting attributes such as at least one of the live event 37102, a team, a player, an amount of wager, etc. The user database 37126 may include but is not limited to information related to all the users involved in the live event 37102. In one exemplary embodiment, the user database 37126 may include information for generating a user authenticity report and a wagering verification report. Further, the user database 37126 may be used to store user statistics like, but not limited to, the retention period for a particular user, frequency of wagers placed by a particular user, the average amount of wager placed by each user, etc.

Further, embodiments may include a historical plays database 37128 that may contain play data for the type of sport being played in the live event 37102. For example, in American Football, for optimal odds calculation, the historical play data may include metadata about the historical plays, such as time, location, weather, previous plays, opponent, physiological data, etc.

Further, embodiments may utilize an odds database 37130—that may contain the odds calculated by an odds calculation module 37132—to display the odds on the user's mobile device 37108 and take bets from the user through the mobile device wagering app 37110.

Further, embodiments may include the odds calculation module 37132, which may utilize historical play data to calculate odds for in-play wagers.

Further, embodiments may include a send data module 37134, which may begin with the send data module 37134 continuously polling for a request for the user data from the data collection module 37114. For example, there may be an option in the wagering app 37110 to allow users to request to download their data, such as a user ID, a device identifier, a paired device identifier, wagering history, or wallet information for the user. Also, the data may include user interests, user personal details such as age, mobile number, etc., previously played sporting events, highest wager, favorite sporting event, or current user balance and standings. Then the send data module 37134 may receive a request for the user data from the data collection module 37114. For example, the send data module 37134 may receive a request from the user that they desire to download their data, such as a user ID, a device identifier, a paired device identifier, wagering history, or wallet information for the user. Also, the data may include user interests, user personal details such as age, mobile number, etc., previously played sporting events, highest wager, favorite sporting event, or current user balance and standings. The send data module 37134 may filter the user database 37126 on the received user ID. For example, the send data module 37134 may receive a user ID, and the request for the user data, such as JS12345 and the user database 37126, may be filtered on the user ID JS12345. The send data module 37134 may extract the user data from the user database 37126. For example, the send data module 37134 may extract a user ID, a device identifier, a paired device identifier, wagering history, or wallet information for the user. Also, the data may include user interests, user personal details such as age, mobile number, etc., previously played sporting events, highest wager, favorite sporting event, or current user balance and standings. The send data module 37134 may send the user data to the data collection module 37114. For example, the send data module 37134 may send the extracted data such as a user ID, a device identifier, a paired device identifier, wagering history, or wallet information for the user. Also, the data may include user interests, user personal details such as age, mobile number, etc., previously played sporting events, highest wager, favorite sporting event, or current user balance and standings.

Further, embodiments may include a 3rd Party Network 37136 that may have the ability, through the API 37122, to connect, extract, analyze, etc. the data stored in the local user database 37116 to assist the user in finding trends, strengths, weaknesses, etc. within their wagering habits, allowing the user to use a different system or application than the one offered by the wagering network 37124 to enhance the user's wagering habits.

FIG. 372 illustrates the data collection module 37114. The process may begin with the user selecting, at step 37200, to download the user's data to the device. For example, there may be an option in the wagering app 37110 to allow users to request to download their data, such as a user ID, a device identifier, a paired device identifier, wagering history, or wallet information for the user. Also, the data may include user interests, user personal details such as age, mobile number, etc., previously played sporting events, highest wager, favorite sporting event, or current user balance and standings. Then the data collection module 37114 may connect, at step 37202, to the send data module 37134. The data collection module 37114 may send, at step 37204, a request for the user data to the send data module 37134. For example, the data collection module 37114 may send a request for the user data, such as a user ID, a device identifier, a paired device identifier, wagering history, or wallet information for the user. Also, the data may include user interests, user personal details such as age, mobile number, etc., previously played sporting events, highest wager, favorite sporting event, or current user balance and standings. The data collection module 37114 may receive, at step 37206, the user data from the send data module 37134. For example, the data collection module 37114 may receive the user data, such as a user ID, a device identifier, a paired device identifier, wagering history, or wallet information for the user. Also, the data may include user interests, user personal details such as age, mobile number, etc., previously played sporting events, highest wager, favorite sporting event, or current user balance and standings. Then the data collection module 37114 may store, at step 37208, the user data in the local user database 37116. For example, the data stored in the local user database 37116 may be a user ID, a device identifier, a paired device identifier, wagering history, or wallet information for the user. Also, the data may include user interests, user personal details such as age, mobile number, etc., previously played sporting events, highest wager, favorite sporting event, or current user balance and standings.

FIG. 373 illustrates the viewer module 37120. The process may begin with the viewer module 37120 continuously polling, at step 37300, for the user to select a wager event. For example, the user may select the Boston Red Sox vs. the New York Yankees event. Then the user may select, at step 37302, a wager event. For example, the user may select the Boston Red Sox vs. the New York Yankees event. The user may select, at step 37304, a wager market. For example, the user may select the wagering market for the results of the J. D. Martinez at-bat in the first inning in the Boston Red Sox vs. the New York Yankees event. Then the viewer module 37120 may filter, at step 37306, the local user database 37116 for the first available wager. For example, the viewer module 37120 may filter the local user database 37116 for the previous wagering results for when the user wagered on the outcome of an at-bat, which has multiple wager options such as the batter will hit a single, double, triple, home run, strikeout, walk, fly out, ground out, line out, etc. In some embodiments, the local user database 37116 may be filtered on the outcome of an at-bat involving a specific player or team. In some embodiments, the database may be filtered on the type of wager the user has selected, such as play-by-play wagers, for example, the result of an at-bat, pitch, baserunner, etc. In some embodiments, the database may be filtered for other sports, such as basketball, football, hockey, soccer, etc. The viewer module 37120 may analyze, at step 37308, the user data from the filtered local user database 37116. For example, the viewer module 37120 may analyze the filtered database by further filtering the local user database 37116 based on the wager options such as single, double, triple, etc. and for each wager option determine the number of total bets a user has made and divide the number by the total amount of wins the user has achieved to determine the user's winning percentage on the type of wager, such as if the user has wagered 20 times on the results of an at-bat being a single and has won 5 times wagering on the result of an at-bat being a single then user's wagering percentage may be 25%. The viewer module 37120 may determine, at step 37310, if there are more available wagers. For example, the user's winning percentage for the wagering on the result to be a single may be 25%. Still, there may be other wagering options available to the user such as double, triple, home run, strikeout, walk, fly out, ground out, line out, etc. and the next available wager, such as a double, may be selected and the local user database 37116 may be filtered on the result being a double. If there are more available wagers, then the viewer module may filter, at step 37312, the local user database 37116 for the next available wager. For example, the user's winning percentage for the wagering on the result to be a single may be 25%. Still, there may be other wagering options available to the user such as double, triple, home run, strikeout, walk, fly out, ground out, line out, etc. and the next available wager, such as a double, may be selected and the local user database 37116 may be filtered on the result being a double. If there are no more available wagers, then the viewer module 37120 may display, at step 37314, the analytics on the data viewer 37118. For example, the viewer module 37120 may display the user's winning percentage for all available wagers, such as 25% for a single, 35% for a double, etc. The viewer module 37120 may determine, at step 37316, if the user selected to set a limit on a wager type. If the user did not select to set a limit on a wager type, then the process may return to continuously polling, at step 37300, for the user to select a wager event. If the user selected to set a limit, then the user may select, at step 37318, the wager type. For example, the user may select to set a limit on the amount of money they can wager on a specific wager once they see their winning percentage, so the user may desire to set a limit of $10 on wagering for the at-bat result to be a single since their winning percentage is only 25%. Then the user may input, at step 37320, the limit. For example, the user may input a limit for the amount of money they can wager on a specific wager, such as a $10 limit on wagering for the at-bat result to be a single since their winning percentage is only 25% . . . . The viewer module 37120 may store, at step 37322, the limit and the wager type in the local user database 37116. For example, the data stored may be the monetary limit that a user can wager on a specific wager and the wager type to prevent the user from wagering too much money on the specific wager type.

FIG. 374 illustrates the send data module 37134. The process may begin with the send data module 37134 continuously polling, at step 37400, for a request for the user data from the data collection module 37114. For example, there may be an option in the wagering app 37110 to allow users to request to download their data, such as a user ID, a device identifier, a paired device identifier, wagering history, or wallet information for the user. Also, the data may include user interests, user personal details such as age, mobile number, etc., previously played sporting events, highest wager, favorite sporting event, or current user balance and standings. Then the send data module 37134 may receive, at step 37402, a request for the user data from the data collection module 37114. For example, the send data module 37134 may receive a request from the user that they desire to download their data, such as a user ID, a device identifier, a paired device identifier, wagering history, or wallet information for the user. Also, the data may include user interests, user personal details such as age, mobile number, etc., previously played sporting events, highest wager, favorite sporting event, or current user balance and standings. The send data module 37134 may filter, at step 37404, the user database 37126 on the received user ID. For example, the send data module 37134 may receive a user ID, and the request for the user data, such as JS12345 and the user database 37126, is filtered on the user ID JS12345. The send data module 37134 may extract, at step 37406, the user data from the user database 37126. For example, the send data module 37134 may extract a user ID, a device identifier, a paired device identifier, wagering history, or wallet information for the user. Also, the data may include user interests, user personal details such as age, mobile number, etc., previously played sporting events, highest wager, favorite sporting event, or current user balance and standings. The send data module 37134 may send, at step 37408, the user data to the data collection module 37114 and return to step 37400. For example, the send data module 37134 may send the extracted data such as a user ID, a device identifier, a paired device identifier, wagering history, or wallet information for the user. Also, the data may include user interests, user personal details such as age, mobile number, etc., previously played sporting events, highest wager, favorite sporting event, or current user balance and standings.

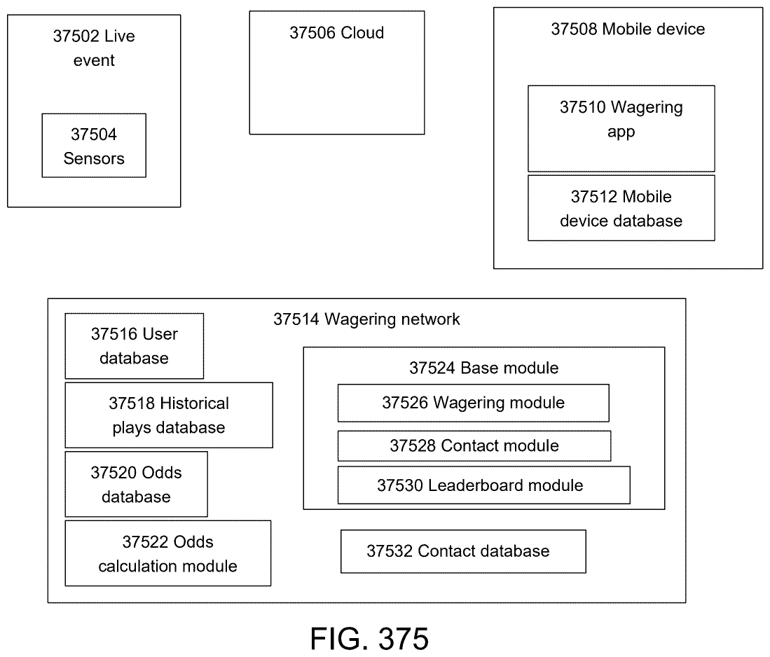

FIG. 375 illustrates a user data comparison system, according to an embodiment.

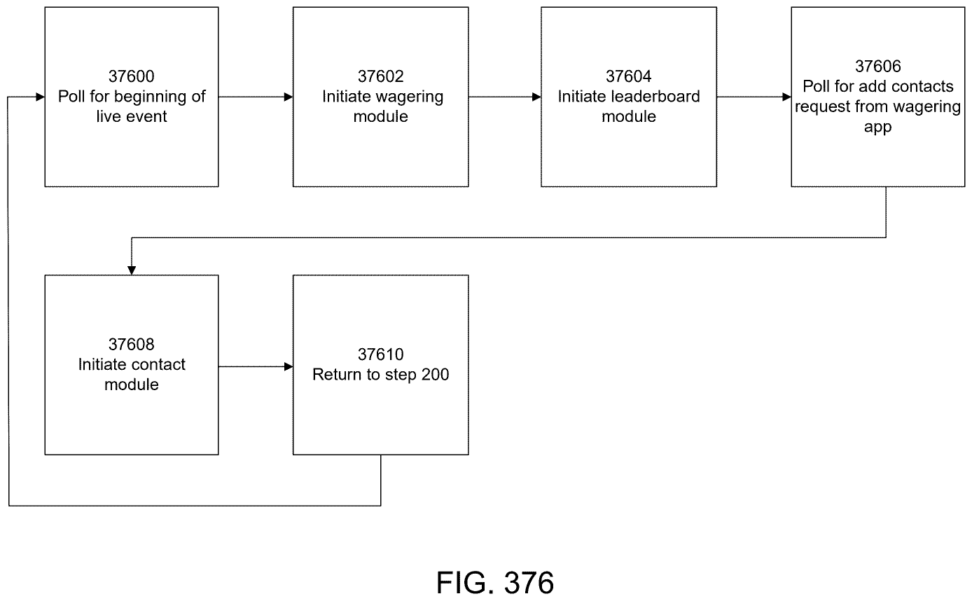

FIG. 376 illustrates a base module, according to an embodiment.

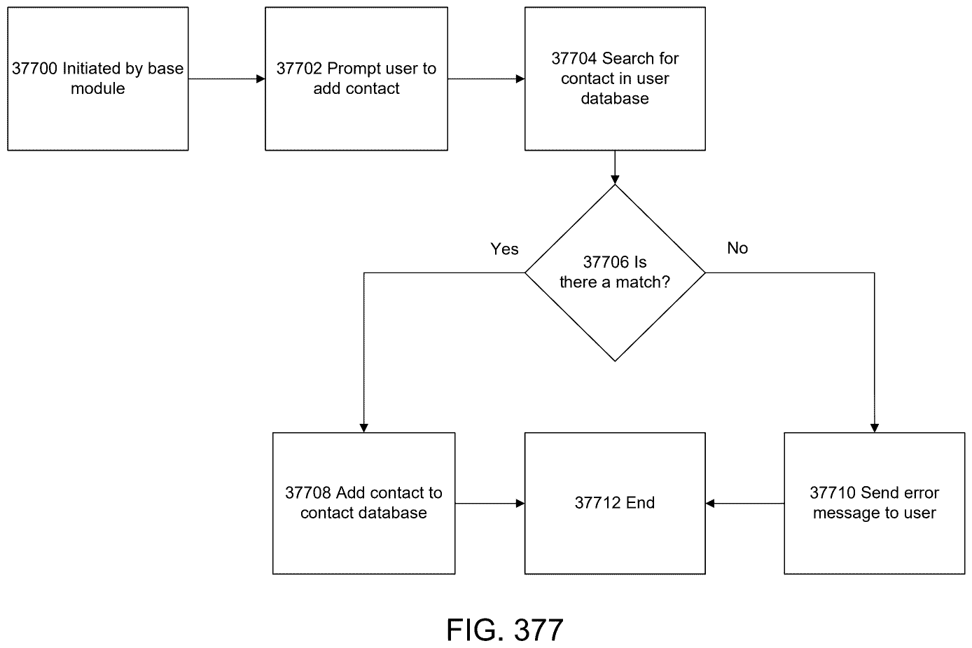

FIG. 377 illustrates a contact module, according to an embodiment.

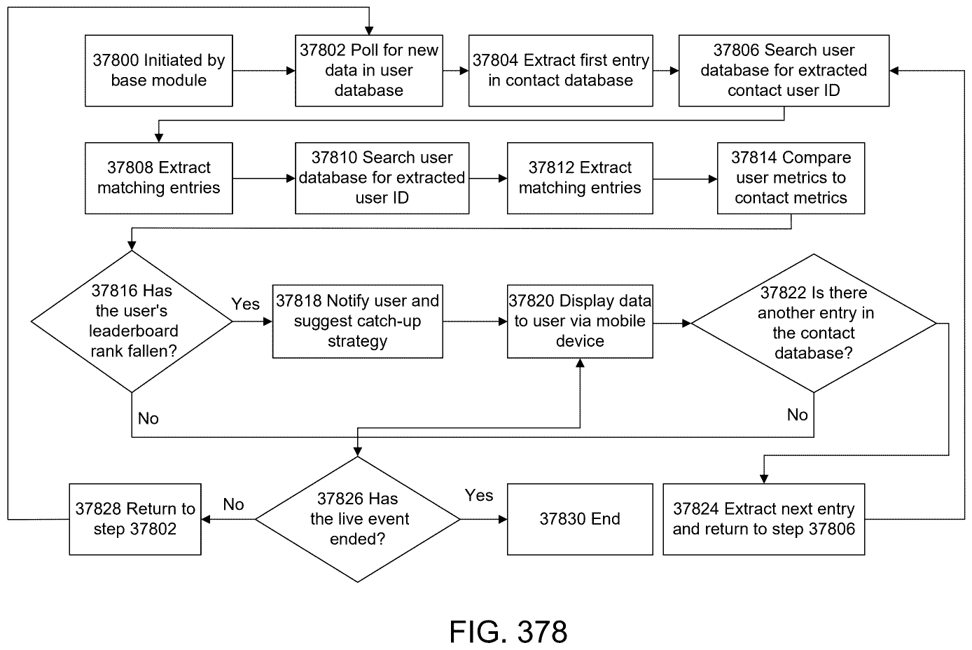

FIG. 378 illustrates a leaderboard module, according to an embodiment.

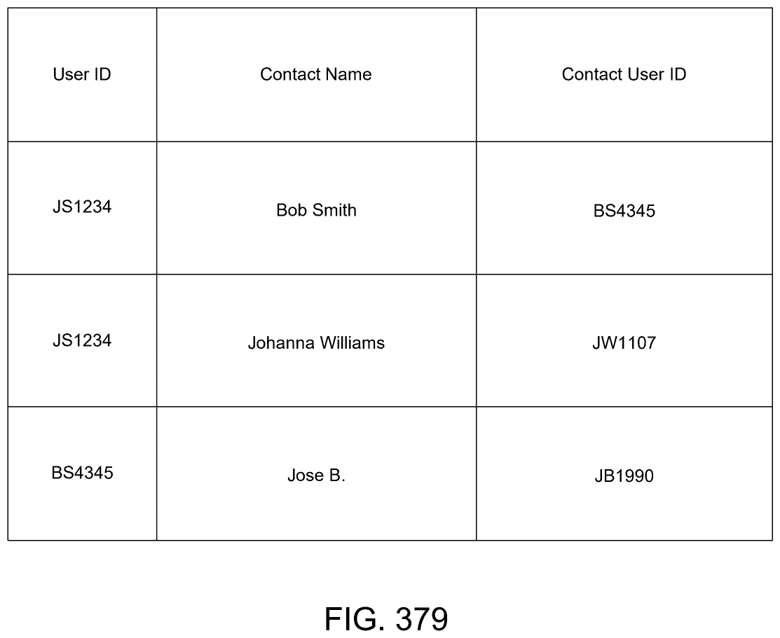

FIG. 379 illustrates a contact database, according to an embodiment.

FIG. 375 is a user data comparison system. This system may include a live event 37502, for example, a sporting event such as a football game, basketball game, baseball game, hockey game, tennis match, golf tournament, eSports or digital game, etc. The live event 37502 may include some number of actions or plays, upon with a user or bettor or customer can place a bet or wager, typically through an entity called a sportsbook. There are numerous types of wagers the bettor can make, including a straight bet, a money line bet, a bet with a point spread or line that the bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk. This is typically applied to round-robin or other tournaments' styles. There are other types of wagers, including parlays, teasers, and prop bets, that are added games that often allow the user to customize their betting by changing the odds and payouts they receive on a wager. Certain sportsbooks will allow the bettor to buy points to move the point spread off of the opening line. This will increase the price of the bet, sometimes by increasing the juice, vig, or hold that the sportsbook takes. Another type of wager the bettor can make is an over/under, in which the user bets over or under a total for the live event 37502, such as the score in American football or the run line in baseball, or a series of action in the live event 37502. Sportsbooks have several bets they can handle, a limit of wagers they can take on either side of a bet before they will move the line or odds off of the opening line. Additionally, there are circumstances, such as an injury to an important player such as a listed pitcher, in which a sportsbook, casino, or racino will take an available wager off the board. As the line moves there becomes an opportunity for a bettor to bet on both sides at different points spreads to middle, and win, both bets. Sportsbooks will often offer bets on portions of games, such as first-half bets and half-time bets. Additionally, the sportsbook can offer futures bets on live events in the future. Sportsbooks need to offer payment processing services in order to cash out customers. This can be done at kiosks at the live event 37502 or at another location.

Further, embodiments may include a plurality of sensors 37504 that may be used such as motion sensors, temperature sensors, humidity sensors, cameras such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices, etc. Also, the plurality of sensors 37504 may include tracking devices, such as RFID tags, GPS chips, or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball.

Further, embodiments may include a cloud 37506 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, and other communication techniques that are known in the art. The communication network may allow ubiquitous access to shared pools of configurable system resources and higher-level services that can be rapidly provisioned with minimal management effort, often over the internet, and relies on sharing of resources to achieve coherence and economics of scale, like a public utility. In contrast, third-party clouds allow organizations to focus on their core businesses instead of expending resources on computer infrastructure and maintenance. The cloud 37506 may be communicatively coupled to a peer-to-peer wagering network 37514, which may perform real-time analysis on the type of play and the result of the play. The cloud 37506 may also be synchronized with game situational data, such as the time of the game, the score, location on the field, weather conditions, and the like, which may affect the choice of play utilized. For example, in other exemplary embodiments, the cloud 37506 may not receive data gathered from sensors 37504 and may, instead, receive data from an alternative data feed, such as Sports Radar®. This data may be compiled substantially immediately following the completion of any play, and the data from this feed may be compared with a variety of team data and league data based on a variety of elements, including down, possession, score, time, team, and so forth, as described in various exemplary embodiments herein.

Further, embodiments may include a mobile device 37508 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs by combining some of the inputs and outputs. Some devices allow for facial recognition, which may be utilized as an input for different purposes, including authentication and other commands. Some devices provide for voice recognition and inputs, including, e.g., Microsoft KINECT, SIRI for iPhone by Apple, Google Now, or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality, including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices, or group of devices may be augmented reality devices. An I/O controller may control the I/O devices. The I/O controller may control one or more I/O devices, such as e.g., a keyboard and a pointing device, e.g., a mouse or optical pen. Furthermore, an I/O device may also contain storage and/or an installation medium for the computing device. In other embodiments the computing device may include USB connections (not shown) to receive handheld USB storage devices. In further embodiments, an I/O device may be a bridge between the system bus and an external communication bus, e.g., a USB bus, a SCSI bus, a FireWire bus, an Ethernet bus, a Gigabit Ethernet bus, a Fiber Channel bus, or a Thunderbolt bus. In some embodiments, the mobile device 37508 could be an optional component and would be utilized in a situation where a paired wearable device utilizes the mobile device 37508 as additional memory or computing power or connection to the internet.

Further, embodiments may include a wagering software application or wagering app 37510, which is a program that enables the user to place bets on individual plays in the live event 37502 and display the audio and video from the live event 37502, along with the available wagers on the mobile device 37508. The wagering app 37510 allows the user to interact with the wagering network 37514 to place bets and provide payment/receive funds based on wager outcomes.

Further, embodiments may include a mobile device database 37512 which may store some or all of the user's data, the live event 37502, or the user's interaction with the wagering network 37514.

Further, embodiments may include the wagering network 37514, which may perform real-time analysis on the type of play and the result of a play or action. The wagering network 37514 (or the cloud 37506) may also be synchronized with game situational data, such as the time of the game, the score, location on the field, weather conditions, and the like, which may affect the choice of play utilized. For example, in an exemplary embodiment, the wagering network 37514 may not receive data gathered from the sensors 37504 and may, instead, receive data from an alternative data feed, such as SportsRadar®. This data may be provided substantially immediately following the completion of any play, and the data from this feed may be compared with a variety of team data and league data based on a variety of elements, including down, possession, score, time, team, and so forth, as described in various exemplary embodiments herein. The wagering network 37514 can offer several software as a service managed services such as user interface service, risk management service, compliance, pricing and trading service, IT support of the technology platform, business applications, game configuration, state-based integration, fantasy sports connection, integration to allow the joining of social media, as well as marketing support services that can deliver engaging promotions to the user.

Further, embodiments may include a user database 37516, which may contain data relevant to all users of the wagering network 37514 and may include, but is not limited to, a user ID, a device identifier, a paired device identifier, wagering history, and wallet information for the user. The user database 37516 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 37516 may contain betting lines and search queries. The user database 37516 may be searched based on a search criterion received from the user. Each betting line may include a plurality of betting attributes such as at least one of the live event 37502, a team, a player, an amount of wager, etc. The user database 37516 may include information related to all the users involved in the live event 37502. In one example embodiment, the user database 37516 may include information for generating a user authenticity report and a wagering verification report. Further, the user database 37516 may be used to store user statistics like, but not limited to, the retention period for a particular user, frequency of wagers placed by a particular user, the average amount of wager placed by each user.

Further, embodiments may include a historical plays database 37518 that may contain play data for the type of sport being played in the live event 37502. For example, in American Football, for optimal odds calculation, the historical play data may include metadata about the historical plays, such as time, location, weather, previous plays, opponent, physiological data, etc.

Further, embodiments may utilize an odds database 37520 that contains the odds calculated by an odds calculation module 37522 to display the odds on the user's mobile device 37508 and to take bets from the user through the mobile device wagering app 37510.

Further, embodiments may include the odds calculation module 37522, which utilizes historical play data to calculate odds for in-play wagers

Further, embodiments may include a base module 37524, which may initiate a wagering module 37526, a contact module 37528, and a leaderboard module 37530.

Further, embodiments may include the wagering module 37526, which may be triggered when the user places a wager on the live event 37502. After receiving the prompt, the module may receive a user selection of the highlighted elements. For example, the user selects the highlighted player, i.e., Aaron Judge of the New York Yankees, playing in the 3rd inning against Clayton Kershaw of the LA dodgers. Further, the wagering module 37526 may retrieve available wagers for the selected element. In an embodiment, the wagering module 37526 may retrieve available wagers from the odds database 37520. In this example, the wagering module 37526 retrieves available wagers for Aaron Judge (as a hitter), i.e., a wager on Aaron Judge hitting a single at odds 4/1 and a wager on Aaron Judge hitting a home run at odds 5/1 in the 3rd inning of the match between the New York Yankees and the LA dodgers. Further, the wagering module 37526 may display a menu of available wagers related to the selected element. In an embodiment, the menu may be displayed via the wagering app 37510 on the display of the mobile device 37508. In this example, the wagering module 37526 displays a menu of available wagers for Aaron Judge of the New York Yankees hitting against Clayton Kershaw of the LA Dodgers in the 3rd inning of the match. The menu includes a wager on Aaron Judge hitting a single at odds 4/1 and a wager on Aaron Judge hitting a home run at odds 3/1. Further, the wagering module 37526 may receive a wager from the user. For example, the user places a wager of $100 on Aaron Judge of the New York Yankees, playing in the 3rd inning against Clayton Kershaw of the LA dodgers, hitting a single at odds 4/1. Further, the wagering module 37526 may constantly monitor the live event 37502 for completion. In one case, when the live event 37502 is concluded, then the wagering module 37526 may obtain the results of the live event 37502. For example, the result is that Aaron Judge hits a single during the live event 37502. In another case, when the live event 37502 is not concluded, then the wagering module 37526 may continue monitoring the live event 37502 for completion. Further, the wagering module 37526 may compare the result of the live event 37502 with the wagers placed by the user to determine a result, i.e., whether the user has won or lost. In this example, the wager of $100 placed on Aaron Judge of the New York Yankees, playing in the 3rd inning against Clayton Kershaw of the LA dodgers, hitting a single and the result of the live event 37502, i.e., Aaron Judge of the New York Yankees, playing in the 3rd inning against Clayton Kershaw of the LA dodgers, hits a single, are compared to determine the result of the wager, i.e., a win for the user. Based on the comparison of the result of the live event 37502 and the wagers placed by the user, the wagering module 37526 may calculate the balance amount for the user. For example, the user wins the wager of $100 at +400 odds that Aaron Judge will hit a single on the next play, and the result of the live event 37502 is Aaron Judge hits a single. Thus, the updated balance of the user (with an opening balance of $2000), after the completion of the live event 37502, will be $2000+$400=$2400. Further, the wagering module 37526 may update the account balance of the user who places the wager. In this example, after winning the wager of $100 placed (at odds of 4/1), the user's updated balance, i.e., $2400.

Further, embodiments may include the contact module 37528, which may be executed by the base module 37524 once a user executes an icon on the mobile device 37508. This module requests inputs from the user for friends of the user. This request can be made by entering in the friend's contact information. It may be understood to those of ordinary skill in the art that there are many ways to get a friend's contact information. For instance, but not limited to, friends submitting an invite to a friend via a link from the wagering network 37514 to allow inputting in contacts information; Searching through a list of contacts, and once selected, allowing the friend to approve being on the list; Etc. Once the friend contact information is received, it is stored in a contact database 37532.

Further, embodiments may include the leaderboard module 37530, which may be executed by the base module 37524. During the current play of the live event 37502, the module searches the contact database 37532 for the user's friends. The leaderboard module 37530 then extracts for each friend the historical bets for each game user's friends from the user database 37516. The leaderboard module 37530 module calculates (at the beginning of each new play event) the performance differences between the user and each friend. These performance differences could be, for example, but not limited to, the total % of wins to losses, the total amount bet and the total amount net won or lost, the best streak (consecutive wins), the biggest single win, the biggest single loss, etc. The performance differences may be limited to a subset of past data. For example, but not limited to, the current games time windows (e.g., inning (baseball) or quarter (football), the entire game, the last ten games, the entire history, a subset selected by the user, etc.

Further, embodiments may include the contact database 37532 which may store, for each user, their friends that have been selected to be on their friends list. This database may store the performance metrics by time and by play so that all the performance metrics can later be shown on a leaderboard.

FIG. 376 illustrates the base module 37524. The process begins with the base module 37524 polling, at step 37600, for the beginning of the live event 37502. The start of the live event 37502 may be determined using data from the sensors 37504 of the live event 37502. The base module 37524 initiates, at step 37602, the wagering module 37526. The base module 37524 initiates, at step 37604, the leaderboard module 37530. The base module 37524 polls, at step 37606, for a request from the wagering app 37510 to add a new contact. This request may be sent from the mobile device 37508 by the user. For example, the user may press an “add contact” button. The base module 37524 initiates, at step 37608, the contact module 37528. The base module 37524 returns, at step 37610, to step 37600.

FIG. 377 illustrates the contact module 37528. The process begins with the contact module 37528 being initiated, at step 37700, by the base module 37524. The base module 37524 may be prompted to initiate the contact module 37528 after the user selects to add contacts from the mobile device 37508. The contact module 37528 prompts, at step 37702, the user to add a contact. The user may add a contact by entering the user ID of the contact. The user may add a contact with another identifier, for example, the user's name, if the identifier is stored in the user database 37516. The contact module 37528 searches, at step 37704, for a matching user ID, or another identifier, in the user database 37516. The contact module 37528 determines, at step 37706, if there is a matching entry in the user database 37516. If there is a matching entry, the contact module 37528 adds, at step 37708, the matching entry user ID to the contact database 37532. The user ID of the contact is stored as the “contact user ID” and associated with the user ID of the user adding the contact. If there is no matching entry, the contact module 37528 sends, at step 37710, a notification to the mobile device 37508 that no contact with that user ID, or other identifiers, has been found. The contact module 37528 may return to step 37702. The contact module 37528 ends at step 37712.

FIG. 378 illustrates the leaderboard module 37530. The process begins with the leaderboard module 37530 being, at step 37800, initiated by the base module 37524. The leaderboard module 37530 polls, at step 37802, for a new data entry in the user database 37516. A new data entry may be a wager that has been placed or a wager that was resolved. This may cause the leaderboard module 37530 to update when new data is available. The leaderboard module 37530 extracts, at step 37804, the first entry in the contact database 37532. This entry may contain a user ID and a contact ID. The user ID will be used to obtain the user's wager data, and the contact ID will be used to obtain the contact's wager data. The leaderboard module 37530 may only extract entries with user IDs of active users. The leaderboard module 37530 searches, at step 37806, the user database 37516 for a user ID that matches the contact user ID extracted from the contract database 37530. Identifying a match will return all data on the contact that is stored in the user database 37516. Entries that are not relevant to past wager data may be ignored. The leaderboard module 37530 extracts, at step 37808, all matching entries from the user database 37516. The extracted entries may be limited to a subset of past data, for example, but not limited to, the current games time windows (e.g., inning (baseball) or quarter (football), the entire game, the last ten games, a subset selected by the user, etc. The leaderboard module 37530 searches, at step 37810, the user database 37516 for a user ID that matches the contact user ID extracted from the contact database 37532. Identifying a match will return all data on the user stored in the user database 37516. Entries that are not relevant to past wager data may be ignored. The leaderboard module 37530 extracts, at step 37812, all matching entries from the user database 37516. The extracted entries may be limited to a subset of past data. For example, but not limited to the current games time windows (e.g., inning (baseball) or quarter (football), the entire game, the last ten games, a subset selected by the user, etc. The leaderboard module 37530 compares, at step 37814, metrics for the user to metrics for each of the user's contacts. If there are multiple entries for a metric, the values may be combined. The term combination may be interpreted as any method of merging all similar data in a more digestible form to a user, for example, but not limited to, the total % of wins to losses, the total amount bet, the total amount net won or lost, the best streak (consecutive wins), the biggest single win, the biggest single loss, etc. The user may be assigned a leaderboard rank. For example, if the user has a win rate of 44%, and the user's five contacts have win rates of 48%, 49%, 42%, 44%, and 49%, then the user will have a leaderboard ranking of 3rd. The leaderboard module 37530 determines, at step 37816, if the user's leaderboard rank has fallen compared to the last time the leaderboard module 37530 executed this step. The user's previous leaderboard rank may be stored in a database. If the user's leaderboard rank has fallen, the leaderboard module 37530 notifies, at step 37818, the user. The notification may be sent to the mobile device 37508. The notification may include a message that informs the user that their position on the leaderboard has fallen. The notification may also include suggestions on how the user may reclaim their position on the leaderboard. For example, if the user has fallen in rank on the leaderboard for the largest win, the notification may include which bet option to choose and how much to wager in order to have a chance at reclaiming their rank. The leaderboard module 37530 displays, at step 37820, the combined data to the user that corresponds to the user ID extracted from the contact database 37532. This data may be displayed via the mobile device 37508. For example, a user may be able to see the top 10 highest winnings contacts, the top 40 highest win rate contacts, the top 4 net winnings contacts within a 40-mile radius, etc. The user may be able to view the display via the mobile device 37508. The user may be able to change how the contacts are displayed. The display may be refreshed when there is new data. The leaderboard module 37530 determines, at step 37822, if there is another entry in the contact database 37532. If there is another entry in the contact database 37532, the leaderboard module 37530 extracts, at step 37824, the next entry and returns to step 37806. If there is not another entry in the contact database 37532, the leaderboard module 37530 determines, at step 37826, if the live event 37502 has ended. The end of the live event 37502 may be determined using data from the sensors 37504 of the live event 37502. If the live event 37502 has not ended, the leaderboard module 37530 returns, at step 37828, to step 37802. If the live event 37502 has ended, the leaderboard module 37530 ends at step 37830.

FIG. 379 illustrates the contact database 37532. The contact database 37532 may contain user IDs, for example, JS1234. The database may also contain the names of the user's contacts associated with the user ID, for example, “Bob Smith.” The database may also contain the user ID associated with the contact, for example, BS4345.

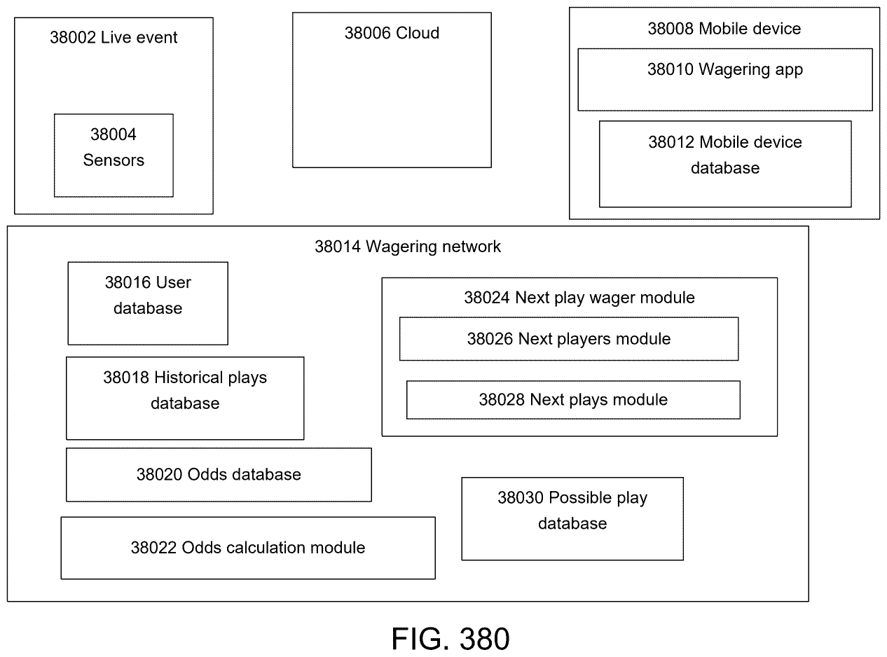

FIG. 380 illustrates a system for an on-deck wagering system, according to an embodiment.

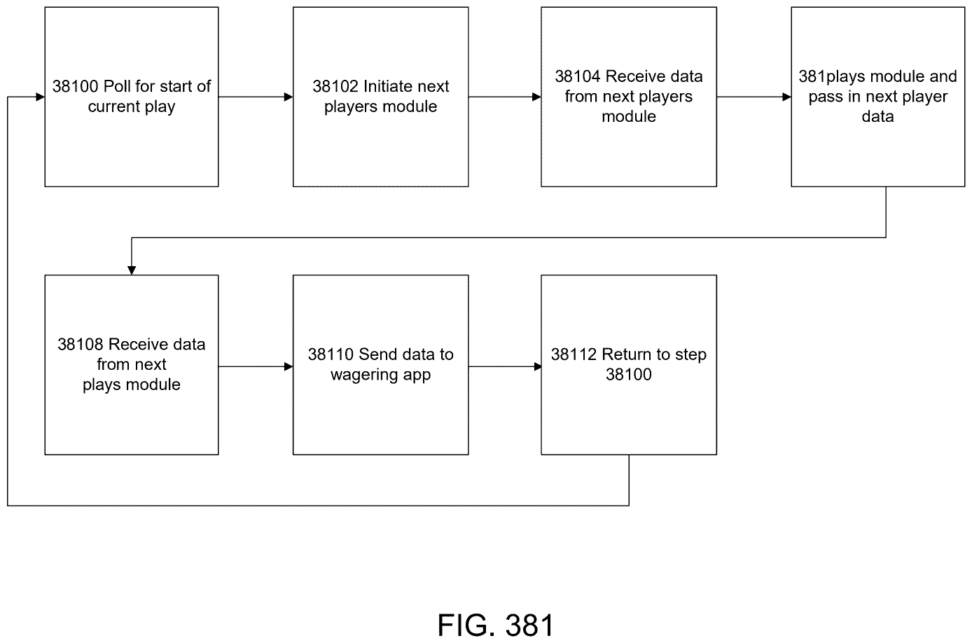

FIG. 381 illustrates a next play wager module, according to an embodiment.

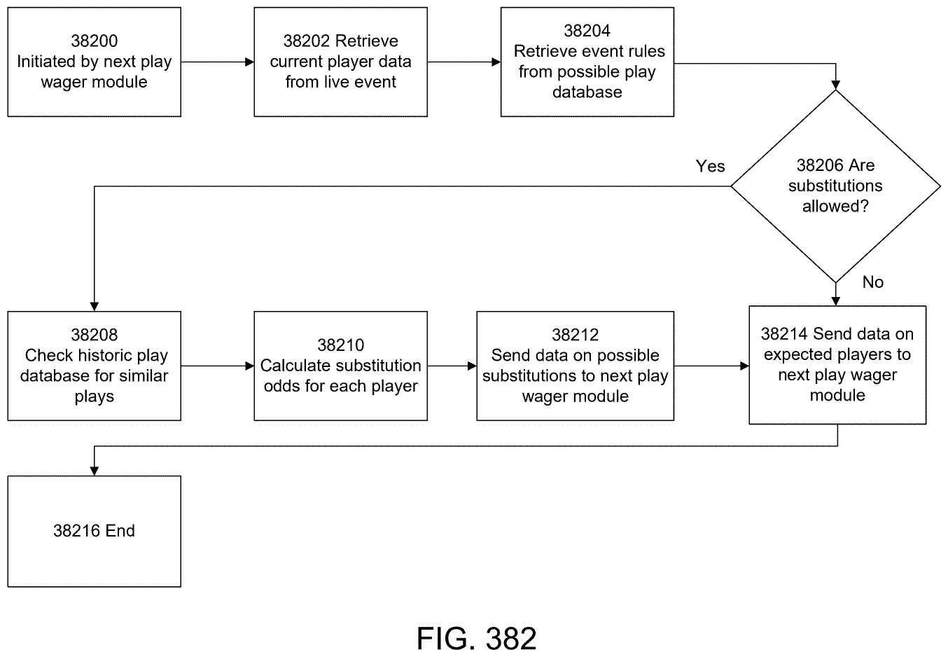

FIG. 382 illustrates a next players module, according to an embodiment.

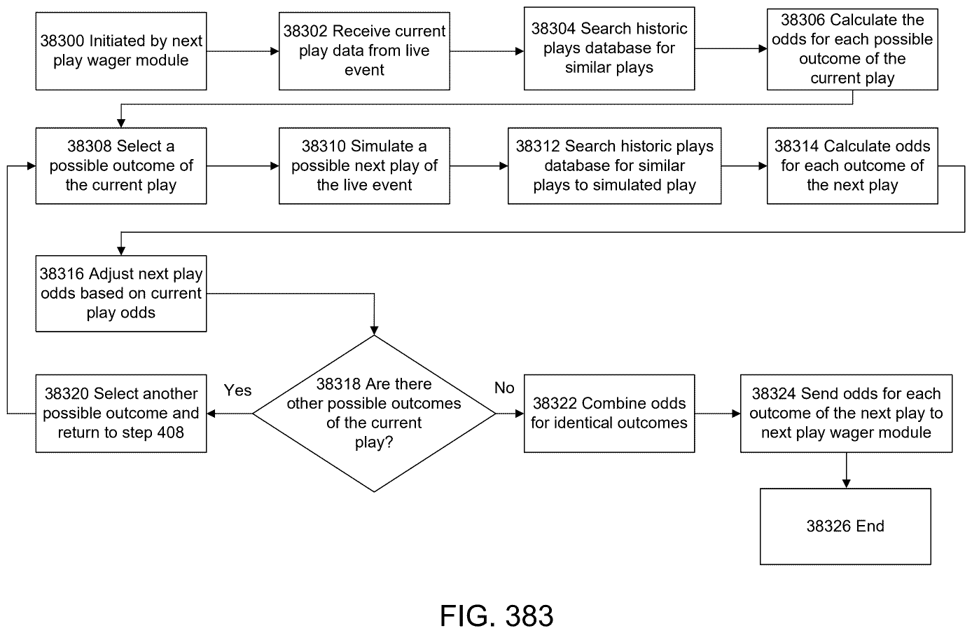

FIG. 383 illustrates a next plays module, according to an embodiment.

FIG. 380 is a system for an on-deck wagering system. This system may include a live event 38002, for example, a sporting event such as a football game, basketball game, baseball game, hockey game, tennis match, golf tournament, eSports or digital game, etc. The live event 38002 will include some number of actions or plays, upon with a user or bettor or customer can place a bet or wager, typically through an entity called a sportsbook. There are numerous types of wagers the bettor can make, including, but not limited to, a straight bet, a money line bet, a bet with a point spread or line that the bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk. This is typically applied to round-robin or other tournaments' styles. There are other types of wagers, including parlays, teasers, and prop bets, that are added games that often allow the user to customize their betting by changing the odds and payouts they receive on a wager. Certain sportsbooks will allow the bettor to buy points, to move the point spread off of the opening line. This will increase the price of the bet, sometimes by increasing the juice, vig, or hold that the sportsbook takes. Another type of wager the bettor can make is an over/under, in which the user bets over or under a total for the live event 38002, such as the score of American football or the run line in baseball, or a series of action in the live event 38002. Sportsbooks have several bets they can handle, a limit of wagers they can take on either side of a bet before they will move the line or odds off of the opening line. Additionally, there are circumstances, such as an injury to an important player such as a listed pitcher, in which a sportsbook, casino, or racino will take an available wager off the board. As the line moves, there becomes an opportunity for a bettor to bet on both sides at different points spreads in order to middle and win both bets. Sportsbooks will often offer bets on portions of games, such as first-half bets and half-time bets. Additionally, the sportsbook can offer futures bets on live events in the future. Sportsbooks need to offer payment processing services in order to cash out customers. This can be done at kiosks at the live event 38002 or at other locations.

Further, embodiments may include a plurality of sensors 38004 that may be used such as motion sensors, temperature sensors, humidity sensors, optical sensors and cameras such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices, etc. Also, the plurality of sensors 38004 may include tracking devices, such as RFID tags, GPS chips, or other such devices embedded on uniforms, in equipment, in the field of play, in the boundaries of the field of play, or on other markers on the field of play. Imaging devices may also be used as tracking devices such as player tracking that provides statistical information through real-time X, Y positioning of players and X, Y, Z positioning of the ball.

Further, embodiments may include a cloud 38006 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, and other communication techniques that are known in the art. The communication network may allow ubiquitous access to shared pools of configurable system resources and higher-level services that can be rapidly provisioned with minimal management effort, often over the internet, and relies on sharing of resources to achieve coherence and economics of scale, like a public utility. In contrast, third-party clouds allow organizations to focus on their core businesses instead of expending resources on computer infrastructure and maintenance. The cloud 38006 may be communicatively coupled to a peer-to-peer wagering network 38014, which may perform real-time analysis on the type of play and the result of the play. The cloud 38006 may also be synchronized with game situational data, such as the time of the game, the score, location on the field, weather conditions, and the like, which may affect the choice of play utilized. For example, in an exemplary embodiment, the cloud 38006 may not receive data gathered from the sensors 38004 and may, instead, receive data from an alternative data feed, such as Sports Radar®. This data may be compiled substantially immediately following the completion of any play, and the data from this feed may be compared with a variety of team data and league data based on a variety of elements, including down, possession, score, time, team, and so forth, as described in various exemplary embodiments herein.

Further, embodiments may include a mobile device 38008 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs by combining some of the inputs and outputs. Some devices allow for facial recognition, which may be utilized as an input for different purposes, including authentication and other commands. Some devices provide for voice recognition and inputs, including, e.g., Microsoft KINECT, SIRI for iPhone by Apple, Google Now, or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality, including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control the I/O devices. The I/O controller may control one or more I/O devices, such as e.g., a keyboard and a pointing device, e.g., a mouse or optical pen. Furthermore, an I/O device may also contain storage and/or an installation medium for the computing device. In still other embodiments, the computing device may include USB connections (not shown) to receive handheld USB storage devices. In further embodiments, an I/O device may be a bridge between the system bus and an external communication bus, e.g., a USB bus, a SCSI bus, a FireWire bus, an Ethernet bus, a Gigabit Ethernet bus, a Fiber Channel bus, or a Thunderbolt bus. In some embodiments, the mobile device 38008 could be an optional component and would be utilized in a situation where a paired wearable device utilizes the mobile device 38008 as additional memory or computing power or connection to the internet.

Further, embodiments may include a wagering software application or a wagering app 38010, which is a program that enables the user to place bets on individual plays in the live event 38002 and display the audio and video from the live event 38002, along with the available wagers on the mobile device 38008. The wagering app 38010 allows the user to interact with the wagering network 38014 to place bets and provide payment/receive funds based on wager outcomes.

Further, embodiments may include a mobile device database 38012 that may store some or all of the user's data, the live event 38002, or the user's interaction with the wagering network 38014.

Further, embodiments may include the wagering network 38014, which may perform real-time analysis on the type of play and the result of a play or action. The wagering network 38014 (or the cloud 38006) may also be synchronized with game situational data, such as the time of the game, the score, location on the field, weather conditions, and the like, which may affect the choice of play utilized. For example, in an exemplary embodiment, the wagering network 38014 may not receive data gathered from the sensors 38004 and may, instead, receive data from an alternative data feed, such as SportsRadar®. This data may be provided substantially immediately following the completion of any play, and the data from this feed may be compared with a variety of team data and league data based on a variety of elements, including down, possession, score, time, team, and so forth, as described in various exemplary embodiments herein. The wagering network 38014 can offer several software as a service managed services such as user interface service, risk management service, compliance, pricing and trading service, IT support of the technology platform, business applications, game configuration, state-based integration, fantasy sports connection, integration to allow the joining of social media, as well as marketing support services that can deliver engaging promotions to the user.

Further, embodiments may include a user database 38016, which may contain data relevant to all users of the wagering network 38014, which may include, but is not limited to, a user ID, a device identifier, a paired device identifier, wagering history, and wallet information for the user. The user database 38016 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 38016 may contain betting lines and search queries. The user database 38016 may be searched based on a search criterion received from the user. Each betting line may include a plurality of betting attributes such as at least one of the live event 38002, a team, a player, an amount of wager, etc. The user database 38016 may include information related to all the users involved in the live event 38002. In one example, the user database 38016 may include information for generating a user authenticity report and a wagering verification report. Further, the user database 38016 may be used to store user statistics like, but not limited to, the retention period for a particular user, frequency of wagers placed by a particular user, the average amount of wager placed by each user, etc.

Further, embodiments may include a historical play database 38018 that may contain play data for the type of sport being played in the live event 38002. For example, in American Football, for optimal odds calculation, the historical play data may include metadata about the historical plays such as time, location, weather, previous plays, opponent, physiological data, etc.

Further, embodiments may utilize an odds database 38020 that contains the odds calculated by an odds calculation module 38022 to display the odds on the user's mobile device 38008 and take bets from the user through the mobile device wagering app 38010.

Further, embodiments may include the odds calculation module 38022, which utilizes historical play data to calculate odds for in-play wagers

Further, embodiments may include a next play wager module 38024, which calculates the odds on non-current plays based upon the most likely context of the non-current play based on the predicted outcome of the current play. Non-current plays are related to plays that would occur outside the current play or bet. For instance, when a batter is up in a baseball game, there are play events to bet on inside that play, such as will the next pitch result in a ball, a strike, etc., but a play outside the play event could be a pitcher change for the next batter, or whether the next batter will walk. The next play wager module 38024, may initiate a next players module 38026. Once the list of the of potential next plays is received, the next player wager module 38026 looks up the players list in the historical plays database 38018 to see if these players have enough plays (say >500) against the event (such as the current pitcher). If there are enough plays, then the next play wager module 38024 calculates the odds for the next plays that could be made, for instance, 2:1 for a strikeout, 3:1 for a single, etc. The next play wager module 38024 may initiate a next plays module 38028. Once the list of the next plays is received, the next play wager module 38024 looks up the plays possibilities in the historical plays database 38018 to see if these plays have enough plays (for example >500) against the event. For example, the context of the current play may be one out in the eighth inning with no runners on base. The context of the next play may be one out and with a runner on first. Multiple outcomes of the current play may result in the next play being in that context. The current player may get a hit, a walk, being hit by a pitch, reaching on an error, or by catcher's interference. The odds of each outcome on the current play may be combined to produce the next play's odds in the context. The odds of at least one outcome of the next play may be combined with the odds of that context to create odds on the outcome of the next play. For example, the next play could be the current player gets on base and then steals the next base, or the current player gets on base and the next player does a sacrifice fly ball out, etc. If there are enough plays, then the next play wager module 38024 calculates the odds for the next plays that could be made, for instance, 2:1 odds that the current player gets on base and then steals the next base, 3:1 odds that the current player gets on base and next player does a sacrifice fly ball out, etc. The next play wager module 38024, then searches a possible play database 38030 for other potential micro plays outside the current play event. For instance, it may evaluate the rules portion of the possible play database 38030 to see if substitute players are permitted in baseball based upon the current play. The next play wager module 38024, looks up the plays possibilities in the historical plays database 38018 to see if these plays have enough plays (for example >500) against the event. For example, a substitution may be made on the next play. If there are enough plays, then the next play wager module 38024 calculates the odds for the next plays that could be made, for instance, 2:1 odds that a substitution is made. The next play wager module 38024 then sends this data to the wagering app 38010 on the mobile device 38008 to offer these new bets outside the current play or bet to be bet on by the user. It may be understood by those of ordinary skill in the art that there are many methods to track betting and results in each game.

Further, embodiments may include the next players module 38026, which may be initiated by the next play wager module 38024. The next players module 38026 determines from a 3rd party sports database the current next players, such as the lineup of players on the roster. For baseball, the batting order or batting lineup is the sequence in which the members of the offense take their turns in batting against the pitcher. The batting order is the main component of a team's offensive strategy. In Major League Baseball, the batting order is set by the manager, who before the game begins must present the home plate umpire with two copies of his team's lineup card, a card on which a team's starting batting order is recorded. The home plate umpire keeps one copy of each team's lineup card and gives the second copy to the opposing manager. Once the home plate umpire gives the lineup cards to the opposing managers, the batting lineup is final, and a manager can only make changes under the official baseball rules governing substitutions. If a team bats out of order, it is a violation of baseball's rules and subject to penalty. In American football, the next players are more difficult to determine as there are unlimited free substitutions, but for a specific play, the players are known. The specific role that a player takes on the field is referred to as their position. Under the modern rules of American football, both teams are allowed 11 players on the field at one time and have unlimited free substitutions, meaning that they may change any number of players during any “dead ball” situation. This has resulted in the development of three task-specific “platoons” of players within any single team: the offense, which is the team with possession of the ball, which is trying to score; the defense, which is the team trying to prevent the other team from scoring and to take the ball from them; and the so-called “special teams”, who play in all kicking situations. Within these three separate “platoons,” various positions exist depending on the job that the player is doing. The next players module 38026 returns the list of the next players, for instance the next players to be at-bat in baseball, to the next play wager module 38024.

Further, embodiments may include the next plays module 38028, which may be initiated by the next play wager module 38024. The next plays module 38028, evaluates the current play event and then uses the data in the possible play database 38030 to determine which plays could potentially be the next play of the live event 38002. For instance, if the current play event is a batter up against a pitcher, and the count is two balls and one strike, a micro play cannot be a strikeout on the next pitch but could be a foul ball, a bunt, etc. So, these plays could realistically be the next play of the live event 38002. The next plays module 38028 returns the list of possible next plays to the next play wager module 38024.

Further, embodiments may include the possible play database 38030, which may store (for each sport) all the possible plays available. For instance, a pitch to a batter in baseball can result in a swinging strike, looking strike, foul ball, a hit, a bunt, a called strike, a ball, etc. In other sports like football, they can run, pass, kick, etc. The possible play database 38030 may also store possible “event plays” that impact which plays are available as the next play. For instance, in baseball, it can be three outs in an inning, nine innings in a game; or in football, how many yards to a first down, how many attempts remaining to achieve a first down, how many quarters, etc. The possible play database 38030 may also store rules of the game, such as in baseball, what is allowed in a tie after the 9th inning; or in football what happens in the field of play, the duration of the match, the start and restart of plays, etc.

FIG. 381 illustrates the next play wager module 38024. The process begins with the next play wager module 38024 polling, at step 38100, for the end of the play of the live event 38002. This data may be obtained via the sensors 38004 of the live event 38002. The next play wager module 38024, may collect data on the current play until enough data has been collected to calculate the odds of each next play accurately, but before the outcome of the current play has been decided. This amount of data can be considered a threshold amount of data needed to accurately calculate odds and, once that threshold is met, data may stop being collected. The next play wager module 38024 initiates, at step 38102, the next players module 38026. The next play wager module 38024 receives, at step 38104, data from the next players module 38026 on which players may be involved in the next play and the odds of those players being involved in the next play. The next play wager module 38024 initiates, at step 38106, the next plays module 38028 and passes on the data from the next players module 38026. The next play wager module 38024 receives, at step 38108, data from the next plays module 38028 on which plays may be the next play of the live event 38002 and the odds of each play being the next play of the live event 38002. The next play wager module 38024 sends, at step 38110, the possible next plays and odds received from the next plays module 38028 to the wagering app 38010 on the mobile device 38008. The odds may be adjusted at this step to account for factors such as profit and risk. Users may then be able to place wagers on what the next play of the game may be, which players may be part of the next play, or both. There are a number of ways that the odds of a substitution on the next play and the odds on the context of the play may be combined to create odds on a subsequent play. In an embodiment, the odds of substitution in a given scenario may impact the odds of one or more potential outcomes of the next play based on the players available for a given substitution. For example, Aaron Judge is at-bat with no runners on base against Clayton Kershaw with two outs in the eighth inning of a game that the Dodgers lead three to one. Being down by two runs may make the odds of a walk increase as it is common practice in baseball to try for a walk, when possible, to bring the game-tying run to the plate. Left-hand hitting Brett Gardner is on deck. Both Clayton Kershaw and Brett Gardner being left-handed may increase the odds of Brett Gardner being substituted for a right-handed batter if Aaron Judge gets on base to continue the inning. It may be determined based on the active roster and the historical plays database 38018 that the most likely substitute is Giancarlo Stanton. Giancarlo Stanton's historical performance against left-handed pitchers, and Clayton Kershaw specifically, and or as a pinch hitter, may be used to adjust the odds offered to users through the wagering app 38010. The next play wager module 38024 returns, at step 38112, to step 38100.

FIG. 382 illustrates the next players module 38026. The process begins with the next players module 38026 being, at step 38100, initiated by the next play wager module 38024. The next players module 38026, retrieves, at step 38202, data regarding the active players in the live event 38002. For example, the current pitcher and batter in a baseball game, along with the current batting order, available reserves, and any pitchers warming up in the bullpen or on-deck circle. The data may be obtained through the sensors 38004 at the live event 38002. This data may be obtained from a database that stores a player roster. The next players module 38026 retrieves, at step 38204, the rules of the live event 38002 from the possible play database 38030. For example, if the live event 38002 is a baseball game the next players module 38026 will retrieve the rules of baseball from the possible play database 38030. Only the subset of rules dealing with the currently active players may need to be retrieved. The next players module 38026 determines, at step 38206, if substitutions are allowed based on the rules of the live event 38002. If substitutions are not allowed the next players module 38026 skips to step 38114. If substitutions are allowed the next players module 38026 checks, at step 38208, the historical plays database 38018 for plays similar to the current play of the live event 38002. The next players module 38026 calculates, at step 38210, the odds of a substitution for any player that can be substituted. The next players module 38026 may first discard any historical substitutions of players not currently present at the live event 38002, or that are no longer part of the roster. This data may be obtained via the sensors 38004 of the live event 38002 or from a database containing team rosters. Then the odds of each player being substituted may be calculated by looking at the total number of similar plays, then looking at how many times that player was substituted in out of all the similar plays. For example, the current play of the live event 38002 is set to be a left-handed batter facing off against a left-handed pitcher based on the lineup. The search of the historical plays database 38018 returns 500 plays that originally had left-handed batter facing off against a left-handed pitcher in the eighth inning of a game with the batting team trailing by between one and three runs. In 100 of these similar plays a right-handed batter was substituted for the scheduled left-handed batter. Therefore, there is a 100 in 500 (or 20%) estimated chance that a right-handed batter will be at bat instead of a left-handed in the next play of the live event 38002. The identity of the pitcher and batter may be used if there are a sufficient number of matchups in the historical plays database 38018 for a relevant statistic. For example, the batting team may only have one right-handed batter available to pinch-hit. The statistics of the available batter, such as their batting average, slugging percentage, OPS, etc., against left-handed pitching, against the current pitcher, as a pinch hitter, etc. These statistics may be compared to the available substitute players' statistics, the manager's history of substitutions, etc., to determine if a substitution is less or more likely. For example, the current batter may have favorable statistics against same-side pitchers, also known as a reverse platoon split, and would be less likely to be substituted for. The available substitute batter may have a characteristic that may make him less likely to be used in this scenario, such as being the backup catcher. Baseball teams rarely use their backup catcher as a substitute in case the starting catcher gets hurt or ejected. The next players module 38026 sends, at step 38212, the data on the possible substitutions and the odds of each to the next play wager module 38024. The next players module 38026 sends, at step 38214, the expected players of the next play without any substitutions to the next play wager module 38024. The odds of any expected player being in the next play may be calculated as 100% minus the chance of substituting for that player. The next players module 38026 ends at step 38216.

FIG. 383 illustrates the next plays module 38028. The process begins with the next plays module 38028 being initiated, at step 38300, by the next play wager module 38024. The next plays module 38028 may also receive data on the odds of a player substitution as calculated by the next players module 38026. The next plays module 38028 retrieves, at step 38302, current play data from the live event 38002. For example, the play may be the bottom of the eighth inning, and two outs in baseball, and the Yankees are at-bat. This data may be obtained via the sensors 38004 of the live event 38002. The next plays module 38028 searches, at step 38304, the historical plays database 38018 for plays similar to the current play of the live event 38002. The next plays module 38028 calculates, at step 38306, the odds of each outcome of the current play of the live event 38002 based on similar historic plays. For example, if, out of 500 similar plays, 200 resulted in a strikeout, then the calculated odds of a strikeout on the current play of the live event 38002 would be 200 out of 500 (or 40%). The next plays module 38028 selects, at step 38308, one of the possible play outcomes such as a strikeout, single, homerun, etc. The next plays module 38028 may additionally use the received odds of a player substitution from the next players module 38026 to create a possible outcome. For example, the current play's possible outcome may be a single and then a pinch hitter substitution, instead of just a single with the expected hitter. The odds for these outcomes may be calculated by multiplying the odds for the play result by the odds of the next player. For example, if there is a 20% chance of the play resulting in a single and a 10% chance of the expected hitter to be substituted by a pinch hitter, then the odds of an outcome where both occur is 2%. The next plays module 38028 simulates, at step 38310, a possible next play of the live game 38002 based on the outcome selected in step 38208. For example, the current play is bottom of the third inning, and two outs in baseball and the Yankees are at-bat. The selected outcome is a single with no player substitution. Then the simulated play will be the bottom of the third inning and two outs in baseball; the expected next batter is at-bat, and the batter from the current play is on first. The next plays module 38028 searches, at step 38312, the historical plays database 38018 for plays similar to the simulated next play of the live event 38002. The next plays module 38028 calculates, at step 38314, the odds of each outcome of the simulated next play of the live event 38002 based on similar historic plays. For example, if out of 500 similar plays 200 were a strikeout, then the calculated odds of a strikeout on the current play of the live event 38002 would be 200 out of 500 or 40%. The next plays module 38028 may use data from the possible play database 38030 to eliminate similar historic plays with outcomes that are not possible given the current state of the live event 38002. For example, in the live event 38002, the Yankees have two outs, and the selected outcome from step 38308 is another out. Then the outcome of the simulated next play could not be a home run for the Yankees since, after three outs, the Yankees would now be pitching due to baseball's rules. The next plays module 38028 adjusts, at step 38316, the odds of the simulated next play outcome based on the odds of the outcome of the current play that would result in the simulated play. Adjustment may be made by multiplying the odds together. For example, there is a 40% chance the current play will be a single. If the current play results in a single, there is a 10% chance the next play will be a home run. The two probabilities are multiplied together to result in a 4% chance that the actual next play of the live game 38002 results in a home run. The next plays module 38028 determines, at step 38318, if there are other possible outcomes of the current play that have not been selected. If there are other possible outcomes of the current play that have not been selected the next plays module 38028 selects, at step 38320, another possible outcome and returns to step 38208. If there are no other possible outcomes of the current play that have not been selected, the next plays module 38028 combines, at step 38322, the odds of each identical outcome of the simulated next play. For example, the odds of both current play being a single and the next play being a home run is 4%. The odds of both the current play being a double and the next play being a home run is 2%. Since both of these possible futures have the next play resulting in a home run, the two probabilities may be added together for a probability of 6%. This step may only be necessary for wagers where only the next play is relevant, and the actual result of the current play is not bet on. The next plays module 38028 may also normalize all outcomes, such that all possible outcomes total 100%. The next plays module 38028 sends, at step 38324, the odds for each outcome of the next play to the next play wagering module 38024. The next plays module 38028 ends at step 38326.

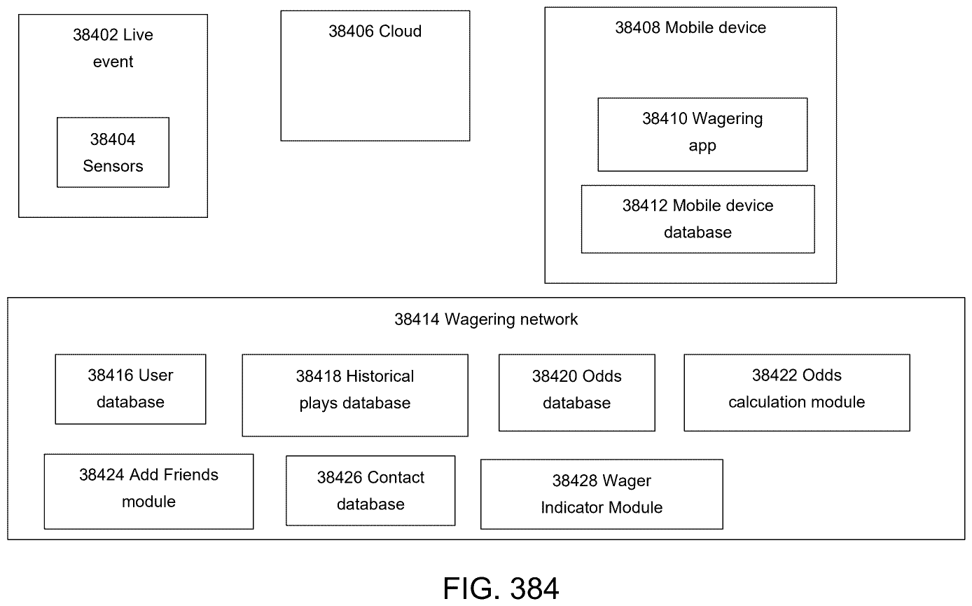

FIG. 384 illustrates a system for notifications for known contact(s) or friend(s) wagers, according to an embodiment.

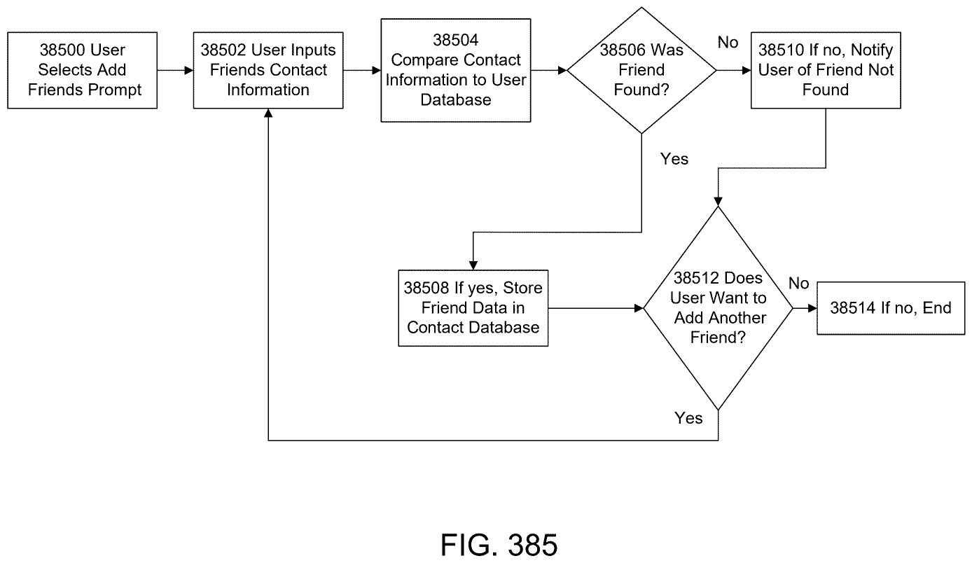

FIG. 385 illustrates an add friends module, according to an embodiment.

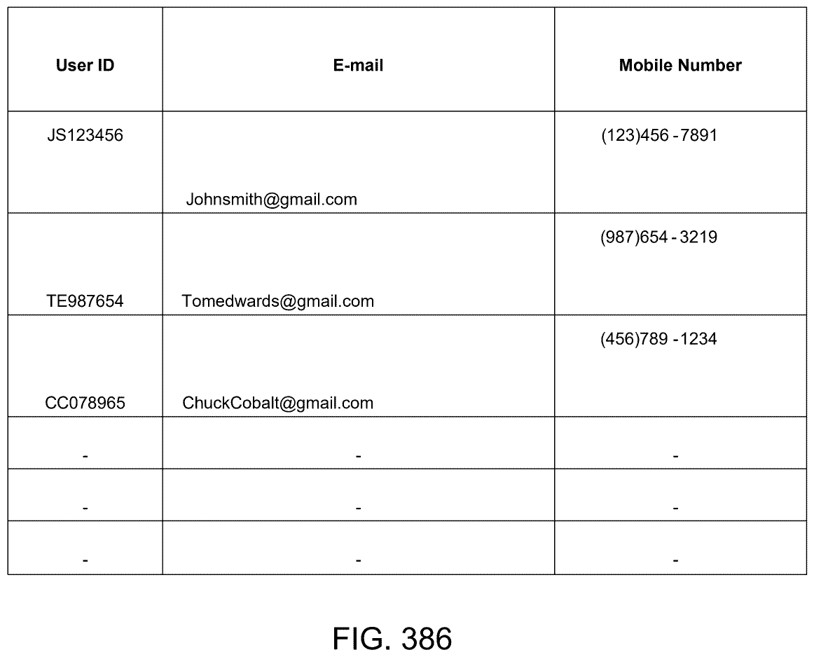

FIG. 386 illustrates a contact database, according to an embodiment.

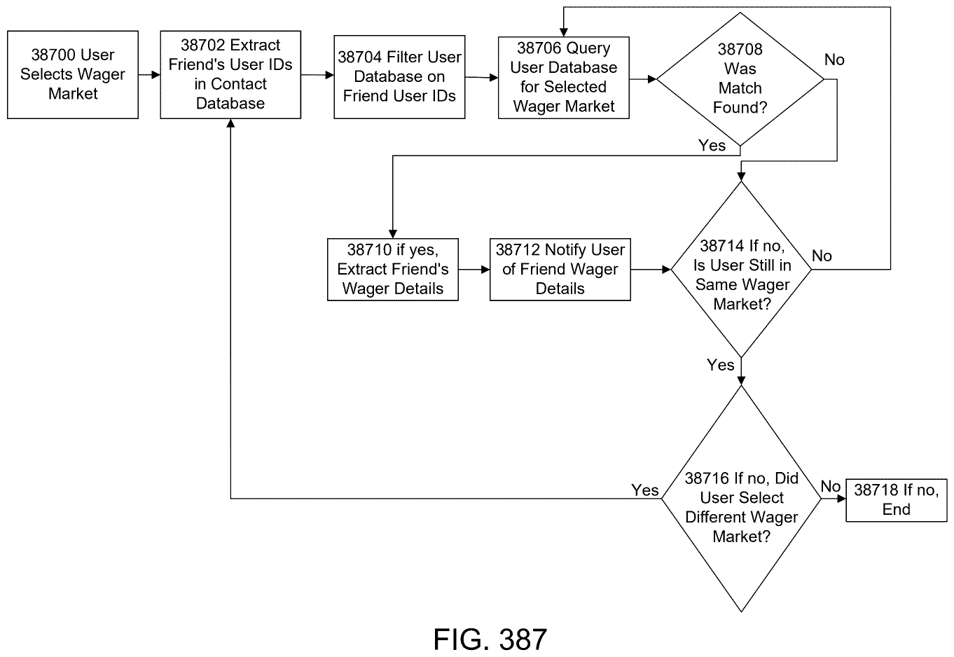

FIG. 387 illustrates a wager indicator module, according to an embodiment.

FIG. 384 is a system for notifications for known contact(s) or friend(s) wagers. This system may include a live event 38402, for example, a sporting event such as a football, basketball, baseball, or hockey game, tennis match, golf tournament, eSports, or digital game, etc. The live event 38402 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 38402, such as the score of an American football game or the run line in a baseball game, or a series of actions in the live event 38402. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 38402 or at another location.

Further, embodiments may include a plurality of sensors 38404 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 38404 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 38406 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 38406 may be communicatively coupled to a peer-to-peer wagering network 38414, which may perform real-time analysis on the type of play and the result of the play. The cloud 38406 may also be synchronized with game situational data such as the time of the game, the score, location on the field, weather conditions, and the like, which may affect the choice of play utilized. For example, in an exemplary embodiment, the cloud 38406 may not receive data gathered from the sensors 38404 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 38408 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 38408 could be an optional component and may be utilized in a situation where a paired wearable device employs the mobile device 38408 for additional memory or computing power or connection to the internet.

Further, embodiments may include a wagering software application or a wagering app 38410, which is a program that enables the user to place bets on individual plays in the live event 38402, streams audio and video from the live event 38402, and features the available wagers from the live event 38402 on the mobile device 38408. The wagering app 38410 allows the user to interact with the wagering network 38414 to place bets and provide payment/receive funds based on wager outcomes.

Further, embodiments may include a mobile device database 38412 that may store some or all the user's data, the live event 38402, or the user's interaction with the wagering network 38414.

Further, embodiments may include the wagering network 38414, which may perform real-time analysis on the type of play and the result of a play or action. The wagering network 38414 (or the cloud 38406) may also be synchronized with game situational data, such as the time of the game, the score, location on the field, weather conditions, and the like, which may affect the choice of play utilized. For example, in an exemplary embodiment, the wagering network 38414 may not receive data gathered from the sensors 38404 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 38414 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 38416, which may contain data relevant to all users of the wagering network 38414 and may include, but is not limited to, a user ID, a device identifier, a paired device identifier, wagering history, or wallet information for the user. The user database 38416 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 38416 may contain betting lines and search queries. The user database 38416 may be searched based on a search criterion received from the user. Each betting line may include but is not limited to, a plurality of betting attributes such as at least one of the following: the live event 38402, a team, a player, an amount of wager, etc. The user database 38416 may include, but is not limited to, information related to all the users involved in the live event 38402. In one exemplary embodiment, the user database 38416 may include information for generating a user authenticity report and a wagering verification report. Further, the user database 38416 may be used to store user statistics like, but not limited to, the retention period for a particular user, frequency of wagers placed by a particular user, the average amount of wager placed by each user, etc.

Further, embodiments may include a historical plays database 38418 that may contain play data for the type of sport being played in the live event 38402. For example, in American Football, for optimal odds calculation, the historical play data may include metadata about the historical plays, such as time, location, weather, previous plays, opponent, physiological data, etc.

Further, embodiments may utilize an odds database 38420—that may contain the odds calculated by an odds calculation module 38422—to display the odds on the user's mobile device 38408 and take bets from the user through the mobile device wagering app 38410.

Further, embodiments may include the odds calculation module 38422, which may utilize historical play data to calculate odds for in-play wagers.

Further, embodiments may include an add friends module 38424 (which may also be known as an add contacts module), which may begin with the user selecting an add friends (or add contacts) prompt on the wagering app 38410 user interface. For example, the wagering app 38410 may have a prompt, button, or icon to add friends through the app. Then the user may input the friend's contact information. For example, the user may input the friends' e-mail addresses, phone numbers, user ID, etc. The add friends module 38424 may compare the inputted contact information to the user database 38416. For example, the e-mail address, phone number, user ID, etc., may be compared to all the e-mail addresses, phone numbers, user IDs, etc., stored in the user database 38416 to see if there are matching entries. Then the add friends module 38424 may determine if there was a match between the inputted contact information and the user database 38416. For example, if there is a match between the e-mail address, phone number, user ID, etc., the user inputted and the e-mail addresses, phone numbers, user IDs, etc., stored in the user database 38416. If there is a match and the friend was found, then the add friends module 38424 may store the friend's data in the contact database 38426. For example, the data stored may be information such as user interests, user personal details such as age, mobile number, e-mail address, user ID, etc., previously played sporting events, sporting events the user is currently playing, highest wager, favorite sporting event, or current user balance and standings. If there is no match and the friend was not found, the add friends module 38424 may notify the user that the friend was not found. Then the add friends module 38424 may determine if the user wants to add another friend. If the user wants to add another friend, then the process may return to the user inputting the contact information. If the user does not want to add another friend, then the process may end.

Further, embodiments may include a contact database 138426, which may contain the user IDs, e-mail addresses, and phone numbers for the friends or contacts that the user has added through the process described in the add friends module 38424. The contact database 38426 may also contain a device identifier, a paired device identifier, wagering history, or wallet information for the user. The contact database 38426 may also contain a list of user account records associated with respective user IDs. For example, a user account record may include, but is not limited to, information such as user interests, user personal details such as age, mobile number, etc., previously played sporting events, currently playing sporting events or wager markets, highest wager, favorite sporting event, or current user balance and standings.

Further, embodiments may include a wager indicator module 38428, which may begin with the user selecting a wagering market. For example, the user selects the Boston Red Sox vs. New York Yankees wager market on a play-by-play wagering network. Then the wager indicator module 38428 may extract the friend's user IDs stored in the contact database 38426. For example, the data stored in the contact database 38426, such as the user IDs, the e-mail addresses, the phone numbers, etc., are extracted. The wager indicator module 38428 may filter the user database 38416 on the extracted user IDs from the contact database 38426. For example, the user database 38416 may be filtered to only include the users in the contact database 38426. The user database 38416 may contain a user ID, a device identifier, a paired device identifier, wagering history, or wallet information for the user. The user database 38416 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. Then the wager indicator module 38428 may query the user database 38416 for the selected wager market. For example, the wager indicator module 38428 may query the user database 38416 for the wagering market of Boston Red Sox vs. New York Yankees, which may be stored in the wagering history section of the user database 38416. The wager indicator module 38428 may determine if there was a match found between the selected wager market by the user and the wager markets stored in the user database 38416. For example, if the user selected the wagering market of Boston Red Sox vs. New York Yankees and in the filtered user database 38416 in the wagering history, there is an entry for one or more of the user's friends placed a wager on the wagering market. If there was a match, then the wager indicator module 38428 may extract the friend's wager details. For example, the wager indicator module 38428 may extract the friend's user ID, name, and the wager placed, such as the 1st pitch of the Boston Red Sox vs. New York Yankees will be a strike. Then the wager indicator module 38428 may notify the user of the friend's wager details. For example, the wager indicator module 38428 may send a notification with the information, such as the friend's user ID, name, and the wager placed, such as the 1st pitch of the Boston Red Sox vs. New York Yankees will be a strike. In some embodiments, the notification may be presented on the wagering app 38410 as a banner notification, text message, message in a chat, a pop-up icon on the user interface, etc. The wager indicator module 38428 may determine if the user is still in the same wager market. If the user is still in the same wager market, the process may return to query the user database 38416 for the selected market with the user database 38416 filtered on the extracted friend user IDs from the contact database 38426. For example, if the user is still in the wagering market of Boston Red Sox vs. New York Yankees, then the process may return to querying the user database 38416 to see if there are additional wagers placed by the user's friends on the same wager market using the wagering history that is stored in the user database 38416. If the user is no longer in the same wager market, then the wager indicator module 38428 may determine if the user selected a different wager market. If the user selected another wager market, then the process may return to extracting the friend's user IDs in the contact database 38426. For example, the user may select a different wager market, such as the Toronto Blue Jays vs. Tampa Rays, and the process may return to extract the data stored in the contact database 38426. If the user did not select another wager market or a different wager market, then the process may end. For example, if the user leaves the wagering market and does not open or select a new wager market, the process may end.

FIG. 385 illustrates the add friends module 38424 (also known as a contacts module). The process may begin with the user selecting, at step 38500, an add friends (or add contacts) prompt on the wagering app 38410 user interface. For example, the wagering app 38410 may have a prompt, button, or icon to add friends through the app. Then the user may input, at step 38502, the friend's contact information. For example, the user may input the friend's e-mail address, phone number, user ID, etc. It may be appreciated that once a friend or contact is added, then that person or entity may be considered as a known contact. The add friends module 38424 may compare, at step 38504, the inputted contact information to the user database 38416. For example, the e-mail address, phone number, user ID, etc., may be compared to all the e-mail addresses, phone numbers, user IDs, etc., stored in the user database 38416 to see if there are matching entries. Then the add friends module 38424 may determine, at step 38506, if there was a match between the inputted contact information and the user database 38416. For example, if there is a match between the e-mail address, phone number, user ID, etc., the user inputted and the e-mail addresses, phone numbers, user IDs, etc., stored in the user database 38416. If there is a match and the friend was found, then the add friends module 38424 may store, at step 38508, the friend's data in the contact database 38426 to make that friend or contact a known contact. For example, the data stored may be information such as user interests, user personal details such as age, mobile number, e-mail address, user ID, etc., previously played sporting events, sporting events the user is currently playing, highest wager, favorite sporting event, or current user balance and standings. If there is no match and the friend was not found, the add friends module 38424 may notify, at step 38510, the user that the friend was not found. Then the add friends module may determine, at step 38512, if the user wants to add another friend. If the user wants to add another friend, then the process may return to step 38502, where the user may input the contact information. If the user does not want to add another friend, then the process may end at step 38514.

FIG. 386 illustrates the contact database 38426. The contact database 38426 may contain the user IDs, e-mail addresses, and phone numbers for the friends or contacts that the user has added through the process described in the add friends module 38424. The contact database 38426 may also contain a device identifier, a paired device identifier, wagering history, or wallet information for the user. The contact database 38426 may also contain a list of user account records associated with respective user IDs. For example, a user account record may include, but is not limited to, information such as user interests, user personal details such as age, mobile number, etc., previously played sporting events, currently playing sporting events or wager markets, highest wager, favorite sporting event, or current user balance and standings.

FIG. 387 illustrates the wager indicator module 38428. The process may begin with the user selecting, at step 38700, a wagering market. For example, the user selects the Boston Red Sox vs. New York Yankees wager market on a play-by-play wagering network. Then the wager indicator module 38428 may extract, at step 38702, the friend's user IDs stored in the contact database 38426. For example, the data stored in the contact database 38426, such as the user IDs, the e-mail addresses, the phone numbers, etc., may be extracted. The wager indicator module 38428 may filter, at step 38704, the user database 38416 on the extracted user IDs from the contact database 38426. For example, the user database 38416 is filtered to only include the users in the contact database 38426. The user database 38416 may contain a user ID, a device identifier, a paired device identifier, wagering history, or wallet information for the user. The user database 38416 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. Then the wager indicator module 38428 may query, at step 38706, the user database 38416 for the selected wager market. For example, the wager indicator module 38428 may query the user database 38416 for the wagering market of Boston Red Sox vs. New York Yankees, which may be stored in the wagering history section of the user database 38416. The wager indicator module 38428 may determine, at step 38708, if there was a match found between the selected wager market by the user and the wager markets stored in the user database 38416. For example, if the user selected the wagering market of Boston Red Sox vs. New York Yankees and in the filtered user database 38416 in the wagering history, there is an entry for one or more of the user's friends placed a wager on the wagering market. If no match was found, the wager indicator module 38428 may skip to step 38714. If there was a match found, then the wager indicator module 38428 may extract, at step 38710, the friends wager details. For example, the wager indicator module 38428 may extract the friend's user ID, name, and the wager placed, such as the 1st pitch of the Boston Red Sox vs. New York Yankees will be a strike. Then the wager indicator module 38428 may notify, at step 38712, the user of the friend's wager details. For example, the wager indicator module 38428 may send a notification with the information, such as the friend's user ID, name, and the wager placed, such as the 1st pitch of the Boston Red Sox vs. New York Yankees will be a strike. In some embodiments, the notification may be presented on the wagering app 38410 as a banner notification, text message, message in a chat, a pop-up icon on the user interface, etc. The wager indicator module 38428 may determine, at step 38714, if the user is still in the same wager market. If the user is still in the same wager market, the process may return to query the user database 38416 for the selected market with the user database 38416 filtered on the extracted friend user IDs from the contact database 38426. For example, if the user is still in the wagering market of Boston Red Sox vs. New York Yankees, then the process may return to querying the user database 38416 to see if there are additional wagers placed by the user's friends on the same wager market using the wagering history that is stored in the user database 38416. If the user is no longer in the same wager market, then the wager indicator module 38428 may determine, at step 38716, if the user selected a different wager market. If the user selected another wager market, then the process may return to extracting the friend's user IDs in the contact database 38426. For example, the user may select a different wager market, such as the Toronto Blue Jays vs. Tampa Rays, and the process may return to extract the data stored in the contact database 38426. If the user did not select another wager market or a different wager market, then the process may end at step 38718. For example, if the user leaves the wagering market and does not open or select a new wager market, the process may end.

FIG. 388 illustrates a system for rolling plays in a drive wager, according to an embodiment.

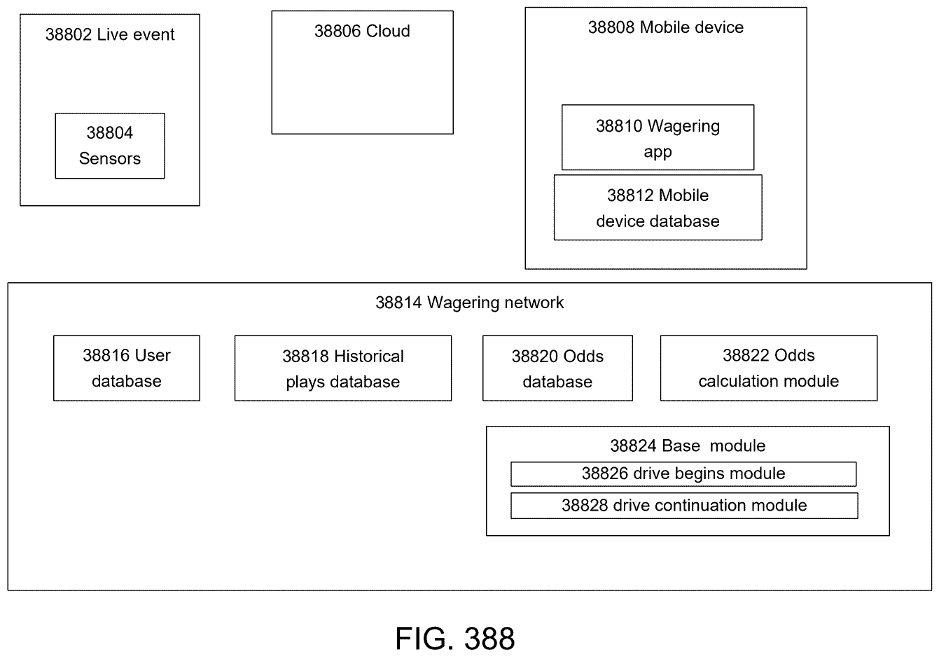

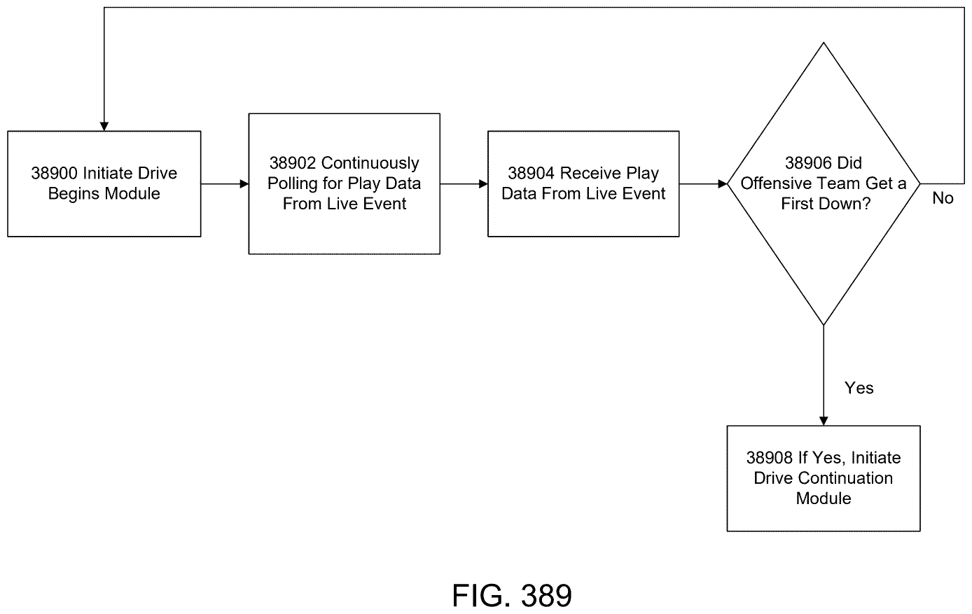

FIG. 389 illustrates a base module, according to an embodiment.

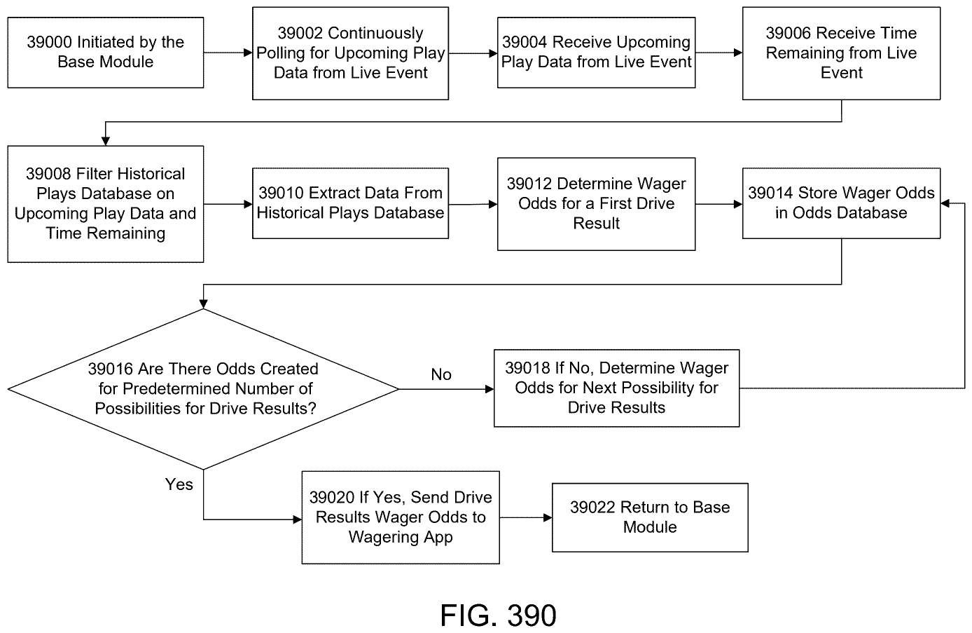

FIG. 390 illustrates a drive begins module, according to an embodiment.

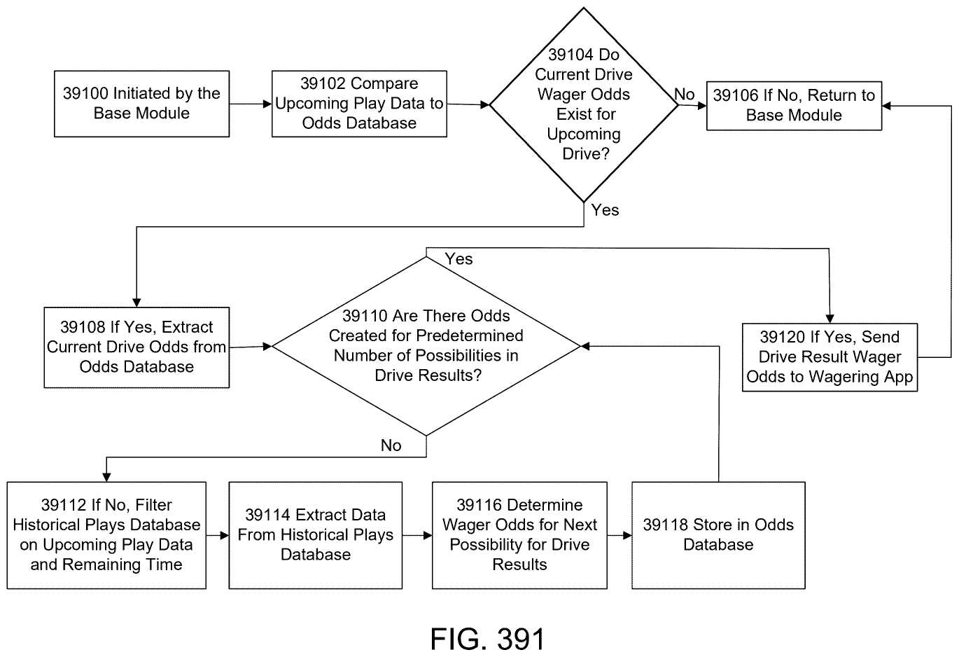

FIG. 391 illustrates a drive continuation module, according to an embodiment.

FIG. 388 is a system for rolling plays in a drive wager. This system may include a live event 38802, for example, a sporting event such as a football, basketball, baseball, or hockey game, tennis match, golf tournament, eSports, or digital game, etc. The live event 38802 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team may need to cover if the result of the game with the same as the point spread the user may not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 38802, such as the score of an American football game or the run line in a baseball game, or a series of actions in the live event 38802. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 38802 or at another location.

Further, embodiments may include a plurality of sensors 38804 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 38804 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 38806 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art.

The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 38806 may be communicatively coupled to a peer-to-peer wagering network 38814, which may perform real-time analysis on the type of play and the result of the play. The cloud 38806 may also be synchronized with game situational data such as the time of the game, the score, location on the field, weather conditions, and the like, which may affect the choice of play utilized. For example, in an exemplary embodiment, the cloud 38806 may not receive data gathered from the sensors 38804 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 38808 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 38808 could be an optional component and may be utilized in a situation where a paired wearable device employs the mobile device 38808 for additional memory or computing power or connection to the internet.

Further, embodiments may include a wagering software application or a wagering app 38810, which is a program that enables the user to place bets on individual plays in the live event 38802, streams audio and video from the live event 38802, and features the available wagers from the live event 38802 on the mobile device 38808. The wagering app 38810 allows the user to interact with the wagering network 38814 to place bets and provide payment/receive funds based on wager outcomes.

Further, embodiments may include a mobile device database 38812 that may store some or all the user's data, the live event 38802, or the user's interaction with the wagering network 38814.

Further, embodiments may include the wagering network 38814, which may perform real-time analysis on the type of play and the result of a play or action. The wagering network 38814 (or the cloud 38806) may also be synchronized with game situational data, such as the time of the game, the score, location on the field, weather conditions, and the like, which may affect the choice of play utilized. For example, in an exemplary embodiment, the wagering network 38814 may not receive data gathered from the sensors 38804 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 38814 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 38816, which may contain data relevant to all users of the wagering network 38814 and may include, but is not limited to, a user ID, a device identifier, a paired device identifier, wagering history, or wallet information for the user. The user database 38816 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 38816 may contain betting lines and search queries. The user database 38816 may be searched based on a search criterion received from the user. Each betting line may include but is not limited to, a plurality of betting attributes such as at least one of the following: the live event 38802, a team, a player, an amount of wager, etc. The user database 38816 may include, but is not limited to, information related to all the users involved in the live event 38802. In one exemplary embodiment, the user database 38816 may include information for generating a user authenticity report and a wagering verification report. Further, the user database 38816 may be used to store user statistics like, but not limited to, the retention period for a particular user, frequency of wagers placed by a particular user, the average amount of wager placed by each user, etc.

Further, embodiments may include a historical plays database 38818 that may contain play data for the type of sport being played in the live event 38802. For example, in American Football, for optimal odds calculation, the historical play data may include metadata about the historical plays, such as time, location, weather, previous plays, opponent, physiological data, etc.

Further, embodiments may utilize an odds database 38820—that may contain the odds calculated by an odds calculation module 38822—to display the odds on the user's mobile device 38808 and take bets from the user through the mobile device wagering app 38810.

Further, embodiments may include the odds calculation module 38822, which may utilize historical play data to calculate odds for in-play wagers.

Further, embodiments may include a base module 38824, which may begin with the base module 38824 initiating the drive begins module 38826. Then the base module 38824 may continuously poll for the upcoming play data from the live event 38802. For example, the base module 38824 may continuously poll to receive the data from the live event 38802 that represents the current state of the live event 38802, such as in the New England Patriots vs. New York Jets event is in the second quarter with one minute and 50 seconds remaining, with New England having possession of the ball on the New England 35-yard line with a first down and ten yards to go. Then the base module 38824 may receive the upcoming play data from the live event 38802. For example, the upcoming play data from the live event 38802 that represents the current state of the live event 38802 may be the New England Patriots vs. New York Jets event is in the second quarter with one minute and 50 seconds remaining, with New England having possession of the ball on the New England 35-yard line with a first down and ten yards to go. Next, the base module 38824 may determine if the offensive team got the first down. For example, the base module 38824 may make this determination if the down resets to 1 if the previous down was 1, 2, or 3, or if the same team has retained possession and the ball is placed or set ten yards further than the previous first down. If the team with possession of the ball has changed, for example, if the New England Patriots are no longer the offensive team and the New York Jets are now the offensive team, then the Patriots have failed to achieve a first down. If the offensive team has failed to achieve a first down, then the process may return to initiating the drive begins module 38826. Then the base module 38824 may initiate the drive continuation module 38828. For example, if the New England Patriots have achieved a first down, then the base module 38824 may initiate the drive continuation module 38828.

Further, embodiments may include a drive begins module 38826, which may begin with the base module 38824 initiating the drive begins module 38826. The drive begins module 38826 may continuously poll for the upcoming play data from the live event 38802. For example, the drive begins module 38826 may continuously poll to receive the data from the live event 38802 that represents the current state of the live event 38802, such as in the New England Patriots vs. New York Jets event is in the second quarter with two minutes and zero seconds remaining, with New England having possession of the ball on the New England 25-yard line with a first down and ten yards to go. Then the drive begins module 38826 may receive the upcoming play data from the live event 38802. For example, the upcoming play data from the live event 38802 that represents the current state of the live event 38802 may be the New England Patriots vs. New York Jets event is in the second quarter, with New England having possession of the ball on the New England 25-yard line with a first down and ten yards to go. Then the drive begins module 38826 may receive the time remaining from the live event 38802. For example, the time remaining might be two minutes and zero seconds remaining in the second quarter. The drive begins module 38826 may filter the historical plays database 38818 on the upcoming play data. For example, the historical plays database 38818 may be filtered for the New England Patriots vs. the New York Jets, with two minutes remaining on first down at the New England 25-yard line. Then the drive begins module 38826, may extract the data from the historical plays database 38818. For example, the drive begins module 38826 may extract all the historical play data associated with the event being the New England Patriots vs. the New York Jets, with two minutes remaining on first down at the New England 25-yard line. The drive begins module 38826 may determine the wager odds. For example, the drive begins module 38826 may determine the average wager odds from the odds of the historical wager extracted from the historical plays database 38818, such as if the number of times or occasions that the New England Patriots scored a touchdown vs. the New York Jets with two minutes remaining before the end of the first half. For example, if the Patriots had 100 drives versus the New York Jets with two minutes remaining before the end of the first half and out of those 100 drives only five times did the Patriots score a touchdown, then there may only be a 5% chance for the drive to result in a touchdown, which the odds may be 100:5 or displayed to the user as 20:1 odds for the drive to result in a touchdown. Then the drive begins module 38826 may store the wager odds in the odds database 38822 as drive results. For example, the wager odds 20:1 may be stored in the odds database 38822 for the New England Patriots drive to result in a touchdown versus the New York Jets. Then the drive begins module 38826 may determine if odds are created for a predetermined number of possibilities for the drive results. For example, there may need to be other odds calculated for the different drive results during the New England Patriots drive versus the New York Jets, such as a field goal, three and out, interception, fumble, five plays, six plays, etc. and the predetermined number of possibilities may be set at seven. For example, for every start of a new drive or new possession, the wagering network may offer users odds for the number of plays that may occur during the drive as well as the possible result of the drive, with each result having different odds, such as the drive resulting in a touchdown at 20:1 odds. If there are not enough odds created for the predetermined number of possibilities in the drive results, then the drive begins module 38826 may determine the wager odds for the next possibility, and the process may return to storing the wager odds in the odds database 38820. For example, in the odds database 38820, the odds for the drive to result in a touchdown are already stored, so the next possibility may be for the drive to result in a field goal. For example, if the Patriots had 100 drives with two minutes remaining in the first half versus the New York Jets and out of those 100 drives only ten times did the drive result in a field goal, then there may only be a 10% chance for the drive to result in a field goal, which the odds may be 100:10 or displayed to the user as 10:1 odds for the drive to result in a field goal. Since the predetermined number of possibilities is set at seven, then the drive begins module 38826 may repeat this loop until the odds are calculated for the drive to result in a touchdown, field goal, three and out, interception, fumble, five plays, or six plays. In some embodiments, the predetermined number of possibilities may be set at any number, and seven is only used as an example. If there are enough odds created for the predetermined number of possibilities for the drive results, then the drive begins module 38826 may send the drive result wager odds to the wagering app 38810. For example, the drive result odds that are sent to the wagering app 38810 may be that the New England Patriots drive ends with a touchdown, at 20:1 odds, results in a field goal, at 10:1 odds, results in a three and out, at 5:1 odds, etc. Then the drive begins module 38826 may return to the base module 38824.

Further, embodiments may include a drive continuation module 38828, which may begin with the drive continuation module 38828 being initiated by the base module 38824. Then the drive continuation module 38828 may compare the upcoming play data to the odds database 38820. For example, the drive continuation module 38828 may compare the date of the event, the time of the event, the teams playing, the time within the event, and the players in the event to determine if there are current drive result odds available. For example, if the date is Sep. 8, 2020, the time of the event is 2:15 pm EST, the teams playing are the New England Patriots vs. the New York Jets, the time within the event is one minute and 50 seconds remaining, and the Patriots have possession of the ball at the New England 35-yard line then the odds database 38820 may contain the record of drive result odds created during the process described in the drive begins module 38826. The drive continuation module 38828 may determine if there is an existing drive wager odds for the upcoming play. For example, the drive continuation module 38828 may compare the date of the event, the time of the event, the teams playing, the time within the event, and the players in the event to determine if there are current drive wager or drive results odds available. For example, if the date is Sep. 8, 2020, the time of the event is 2:15 pm EST, the teams playing are the New England Patriots vs. the New York Jets, the time within the event is the two minutes remaining, and the Patriots have possession of the ball at the New England 25-yard line then the odds database 38820 may contain the record of drive result odds created during the process described in the drive begins module 38826. If there are no drive wager odds available in the odds database 38820, then the drive continuation module 38828 may return to the base module 38824. For example, the drive continuation module 38828 may return to the base module 38824 to create the first drive result odds or drive wager odds. If there are drive result odds available in the odds database 38820, then the drive continuation module 38828 may extract the sequence odds from the odds database 38820. For example, the data extracted may be the date is Sep. 8, 2020, the time of the event is 2:15 pm EST, the teams playing are the New England Patriots vs. the New York Jets, the time within the event is two minutes remaining, and the Patriots have the ball at the New England 25 yard line, with the drive result odds of the drive resulting in a touchdown, at 20:1 odds, resulting in a field goal, at 10:1 odds, resulting in a three and out, at 5:1 odds, etc. Then the drive continuation module 38828 may determine if odds are created for the predetermined number of possibilities in the drive result. For example, a first down has occurred, so the odds of 5:1 for the drive to result in a three and out may no longer be available to the user and thus removed from the drive result odds, this may result in the drive result odds only containing six possibilities, and that may not meet the predetermined threshold of seven possibilities and the corresponding odds. If there are not enough odds created for the predetermined number of possibilities for the drive result odds, then the drive continuation module 38828 may filter the historical plays database 38818 on the upcoming play data. For example, the historical plays database 38818 may be filtered for the New England Patriots vs. New York Jets event is in the second quarter with one minute and 50 seconds remaining, with New England having possession of the ball on the New England 35-yard line with a first down and ten yards to go. Then the drive continuation module 38828 may extract the data from the historical plays database 38818. For example, the drive continuation module 38828 may extract all the historical wagering odds data associated with the event being the New England Patriots vs. New York Jets event is in the second quarter with one minute and 50 seconds remaining, with New England having possession of the ball on the New England 35-yard line with a first down and ten yards to go. The drive continuation module 38828 may determine the wager odds for the next possibility for the drive results odds. For example, the odds for the drive to result in a touchdown, field goal, interception, fumble, five plays, and six plays may be stored in the odds database, so the drive continuation module may need to calculate the odds for the drive resulting in only seven plays. For example, if the Patriots had 100 drives versus the New York Jets and out of those 100 drives only once did the drive result in only seven plays, then there may only be a 1% chance for the drive to last seven plays, which the odds may be 100:1 or displayed to the user as 100:1 odds for the drive to last seven plays. In some embodiments, the drive results odds may be determined for the offensive team to achieve a first down and then from that first down perform three plays and punt. In some embodiments, the drive result odds may be recalculated using the same method for all drive result possibilities, such as touchdown, field goal, interception, fumble, five plays, and six plays. In some embodiments, the drive result odds may be recalculated on a play-by-play basis to calculate more accurate wagering odds. Then the drive continuation module 38828 may store the drive result wager odds in the odds database 38820. For example, the 100:1 odds for the drive to last seven plays may be stored with the current drive result odds in the odds database 38820. If there are enough odds created for the predetermined number of possibilities for the drive results, then the drive continuation module 38828 may send the drive result wager odds to the wagering app 38810, and the process may return to the drive continuation module 38828, returning to the base module 38824. For example, the drive result odds that are sent to the wagering app 38810 may that the New England Patriots drive resulting in a touchdown, at 20:1 odds, resulting in a field goal, at 10:1 odds, up to the drive lasting seven plays, at 100:1 odds.

FIG. 389 illustrates the base module 38824. The process may begin with the base module 38824 initiating; at step 38900, the drive begins module 38826. For example, the drive begins module 38826 may begin with the base module 38824, initiating the drive begins module 38826. The drive begins module 38826 may continuously poll for the upcoming play data from the live event 38802. For example, the drive begins module 38826 may continuously poll to receive the data from the live event 38802 that represents the current state of the live event 38802, such as in the New England Patriots vs. New York Jets event is in the second quarter with two minutes and zero seconds remaining, with New England having possession of the ball on the New England 25-yard line with a first down and ten yards to go. Then the drive begins module 38826 may receive the upcoming play data from the live event 38802. For example, the upcoming play data from the live event 38802 that represents the current state of the live event 38802 may be the New England Patriots vs. New York Jets event is in the second quarter, with New England having possession of the ball on the New England 25-yard line with a first down and ten yards to go. Then the drive begins module 38826 may receive the time remaining from the live event 38802. For example, the time remaining might be two minutes and zero seconds remaining in the second quarter. The drive begins module 38826 may filter the historical plays database 38818 on the upcoming play data. For example, the historical plays database 38818 may be filtered for the New England Patriots vs. the New York Jets, with two minutes remaining on first down at the New England 25-yard line. Then the drive begins module 38826, may extract the data from the historical plays database 38818. For example, the drive begins module 38826 may extract all the historical play data associated with the New England Patriots vs. the New York Jets, with two minutes remaining on first down at the New England 25-yard line. The drive begins module 38826 may determine the wager odds. For example, the drive begins module 38826 may determine the average wager odds from the odds of the historical wagers extracted from the historical plays database 38818, such as if the number of times or occasions that the New England Patriots scored a touchdown vs. the New York Jets with two minutes remaining before the end of the first half. For example, if the Patriots had 100 drives versus the New York Jets with two minutes remaining before the end of the first half and out of those 100 drives only five times did the Patriots score a touchdown, then there may only be a 5% chance for the drive to result in a touchdown, which the odds may be 100:5 or displayed to the user as 20:1 odds for the drive to result in a touchdown. Then the drive begins module 38826 may store the wager odds in the odds database 38820 as drive results. For example, the wager odds 20:1 may be stored in the odds database 38820 for the New England Patriots drive to result in a touchdown versus the New York Jets. Then the drive begins module 38826 may determine if odds are created for a predetermined number of possibilities for the drive results. For example, there may need to be other odds calculated for the different drive results during the New England Patriots drive versus the New York Jets, such as a field goal, three and out, interception, fumble, five plays, six plays, etc. and the predetermined number of possibilities may be set at seven. For example, for every start of a new drive or new possession, the wagering network may offer users odds for the number of plays that may occur during the drive as well as the possible result of the drive, with each result having different odds, such as the drive resulting in a touchdown at 20:1 odds. If there are not enough odds created for the predetermined number of possibilities in the drive results, then the drive begins module 38826 may determine the wager odds for the next possibility, and the process may return to storing the wager odds in the odds database 38820. For example, in the odds database 38820, the odds for the drive to result in a touchdown are already stored, so the next possibility may be for the drive to result in a field goal. For example, if the Patriots had 100 drives with two minutes remaining in the first half versus the New York Jets and out of those 100 drives only ten times did the drive result in a field goal, then there may only be a 10% chance for the drive to result in a field goal, which the odds may be 100:10 or displayed to the user as 10:1 odds for the drive to result in a field goal. Since the predetermined number of possibilities is set at seven, then the drive begins module 38826 may repeat this loop until the odds are calculated for the drive to result in a touchdown, field goal, three and out, interception, fumble, five plays, or six plays. In some embodiments, the predetermined number of possibilities may be set at any number, and seven is only used as an example. If there are enough odds created for the predetermined number of possibilities for the drive results, then the drive begins module 38826 may send the drive result wager odds to the wagering app 38810. For example, the drive result odds that are sent to the wagering app 38810 may be that the New England Patriots drive ends with a touchdown, at 20:1 odds, results in a field goal, at 10:1 odds, results in a three and out, at 5:1 odds, etc. Then the drive begins module 38826 may return to the base module 38824. Then the base module 38824 may continuously poll, at step 38902, for the upcoming play data from the live event 38802. For example, the base module 38824 may continuously poll to receive the data from the live event 38802 that represents the current state of the live event 38802, such as in the New England Patriots vs. New York Jets event is in the second quarter with one minute and 50 seconds remaining, with New England having possession of the ball on the New England 35-yard line with a first down and ten yards to go. Then the base module 38824 may receive, at step 38904, the upcoming play data from the live event 38802. For example, the upcoming play data from the live event 38802 that represents the current state of the live event 38802 may be the New England Patriots vs. New York Jets event is in the second quarter with one minute and 50 seconds remaining, with New England having possession of the ball on the New England 35-yard line with a first down and ten yards to go. The base module 38824 may determine, at step 38906, if the offensive team got the first down. For example, the base module 38824 may make this determination if the down resets to 1 if the previous down was one, two, or three, or if the same team has retained possession and the ball is placed or set ten yards further than the previous first down. If the team with possession of the ball has changed, for example, if the New England Patriots are no longer the offensive team and the New York Jets are now the offensive team, then the Patriots have failed to achieve a first down. If the offensive team has failed to achieve a first down, then the process may return to initiating the drive begins module 38826. Then the base module 38824 may initiate, at step 38908, the drive continuation module 38828. For example, if the New England Patriots have achieved a first down, then the base module 38824 may initiate the drive continuation module 38828. For example, the drive continuation module 38828 may begin with the drive continuation module 38828 being initiated by the base module 38824. Then the drive continuation module 38828 may compare the upcoming play data to the odds database 38820. For example, the drive continuation module 38828 may compare the date of the event, the time of the event, the teams playing, the time within the event, and the players in the event to determine if there are current drive result odds available. For example, if the date is Sep. 8, 2020, the time of the event is 2:15 pm EST, the teams playing are the New England Patriots vs. the New York Jets, the time within the event is one minute and 50 seconds remaining, and the Patriots have possession of the ball at the New England 35-yard line then the odds database 38820 may contain the record of drive result odds created during the process described in the drive begins module 38826. The drive continuation module 38828 may determine if there is an existing drive wager odds for the upcoming play. For example, the drive continuation module 38828 may compare the date of the event, the time of the event, the teams playing, the time within the event, and the players in the event to determine if there are current drive wager or drive results odds available. For example, if the date is Sep. 8, 2020, the time of the event is 2:15 pm EST, the teams playing are the New England Patriots vs. the New York Jets, the time within the event is the two minutes remaining, and the Patriots have possession of the ball at the New England 25-yard line then the odds database 38820 may contain the record of drive result odds created during the process described in the drive begins module 38826. If there are no drive wager odds available in the odds database 38820, then the drive continuation module 38828 may return to the base module 38824. For example, the drive continuation module 38828 may return to the base module 38824 to create the first drive result odds or drive wager odds. If there are drive result odds available in the odds database 38820, then the drive continuation module 38828 may extract the sequence odds from the odds database 38820. For example, the data extracted may be the date is Sep. 8, 2020, the time of the event is 2:15 pm EST, the teams playing are the New England Patriots vs. the New York Jets, the time within the event is two minutes remaining, and the Patriots have the ball at the New England 25 yard line, with the drive result odds of the drive resulting in a touchdown, at 20:1 odds, resulting in a field goal, at 10:1 odds, resulting in a three and out, at 5:1 odds, etc. Then the drive continuation module 38828 may determine if odds are created for the predetermined number of possibilities in the drive result. For example, a first down has occurred, so the odds of 5:1 for the drive to result in a three and out may no longer be available to the user and thus removed from the drive result odds. This may result in the drive result odds only containing six possibilities, and that may not meet the predetermined threshold of seven possibilities and the corresponding odds. If there are not enough odds created for the predetermined number of possibilities for the drive result odds, then the drive continuation module 38828 may filter the historical plays database 38818 on the upcoming play data. For example, the historical plays database 38818 may be filtered for the New England Patriots vs. New York Jets event is in the second quarter with one minute and 50 seconds remaining, with New England having possession of the ball on the New England 35-yard line with a first down and ten yards to go. Then the drive continuation module 38828 may extract the data from the historical plays database 38818. For example, the drive continuation module 38828 may extract all the historical wagering odds data associated with the event being the New England Patriots vs. New York Jets event is in the second quarter with one minute and 50 seconds remaining, with New England having possession of the ball on the New England 35-yard line with a first down and ten yards to go. The drive continuation module 38828 may determine the wager odds for the next possibility for the drive results odds. For example, the drive result odds for the drive to result in a touchdown, field goal, interception, fumble, five plays, and six plays may be stored in the odds database, so the drive continuation module may need to calculate the odds for the drive resulting in only seven plays. For example, if the Patriots had 100 drives versus the New York Jets and out of those 100 drives only once did the drive result in only seven plays, then there may only be a 1% chance for the drive to last seven plays, which the odds may be 100:1 or displayed to the user as 100:1 odds for the drive to last seven plays. In some embodiments, the drive results odds may be determined for the offensive team to achieve a first down and then from that first down perform three plays and punt. In some embodiments, the drive result odds may be recalculated using the same method for all drive result possibilities, such as touchdown, field goal, interception, fumble, five plays, and six plays. In some embodiments, the drive result odds may be recalculated on a play-by-play basis to calculate more accurate wagering odds. Then the drive continuation module 38828 may store the drive result wager odds in the odds database 38820. For example, the 100:1 odds for the drive to last seven plays may be stored with the current drive result odds in the odds database 38820. If there are enough odds created for the predetermined number of possibilities for the drive results, then the drive continuation module 38828 may send the drive result wager odds to the wagering app 38810, and the process may return to the drive continuation module 38828, returning to the base module 38824. For example, the drive result odds that are sent to the wagering app 38810 may that the New England Patriots drive resulting in a touchdown, at 20:1 odds, resulting in a field goal, at 10:1 odds, up to the drive lasting seven plays, at 100:1 odds.

FIG. 390 illustrates the drive begins module 38826. The process may begin with the base module 38824 initiating; at step 39000, the drive begins module 38826. The drive begins module 38826 may continuously poll, at step 39002, for the upcoming play data from the live event 38802. For example, the drive begins module 38826 may continuously poll to receive the data from the live event 38802 that represents the current state of the live event 38802, such as in the New England Patriots vs. New York Jets event is in the second quarter with two minutes and zero seconds remaining, with New England having possession of the ball on the New England 25-yard line with a first down and ten yards to go. Then the drive begins module 38826 may receive, at step 39004, the upcoming play data from the live event 38802. For example, the upcoming play data from the live event 38802 that represents the current state of the live event 38802 may be the New England Patriots vs. New York Jets event is in the second quarter, with New England having possession of the ball on the New England 25-yard line with a first down and ten yards to go. Then the drive begins module 38826 may receive, at step 39006, the time remaining from the live event 38802. For example, the time remaining might be two minutes and zero seconds remaining in the second quarter. The drive begins module 138826 may filter, at step 39008, the historical plays database 38818 on the upcoming play data. For example, the historical plays database 38818 may be filtered for the New England Patriots vs. the New York Jets, with two minutes remaining on first down at the New England 25-yard line. Then the drive begins module 38826 may extract, at step 39010, the data from the historical plays database 38818. For example, the drive begins module 38826 may extract all the historical play data associated with the New England Patriots vs. the New York Jets, with two minutes remaining on first down at the New England 25-yard line. The drive begins module 38826 may determine, at step 39012, the wager odds. For example, the drive begins module 38826 may determine the average wager odds from the odds of the historical wagers extracted from the historical plays database 138818, such as if the number of times or occasions that the New England Patriots scored a touchdown vs. the New York Jets with two minutes remaining before the end of the first half. For example, if the Patriots had 100 drives versus the New York Jets with two minutes remaining before the end of the first half and out of those 100 drives only five times did the Patriots score a touchdown, then there may only be a 5% chance for the drive to result in a touchdown, which the odds may be 100:5 or displayed to the user as 20:1 odds for the drive to result in a touchdown. Then the drive begins module 38826 may store:at step 39014, the wager odds in the odds database 38820 as a drive result. For example, the wager odds 20:1 may be stored in the odds database 38820 for the New England Patriots drive to result in a touchdown versus the New York Jets. Then the drive begins module 38826 may determine, at step 39016, if odds are created for a predetermined number of possibilities for the drive results. For example, there may need to be other odds calculated for the different drive results during the New England Patriots drive versus the New York Jets, such as a field goal, three and out, interception, fumble, five plays, six plays, etc. and the predetermined number of possibilities may be set at seven. For example, for every start of a new drive or new possession, the wagering network may offer users odds for the number of plays that may occur during the drive as well as the possible result of the drive, with each result having different odds, such as the drive resulting in a touchdown at 20:1 odds. If there are not enough odds created for the predetermined number of possibilities in the drive results, then the drive begins module 38826 may determine, at step 39018, the wager odds for the next possibility, and the process may return to storing the wager odds in the odds database 38820, at step 39014. For example, in the odds database 38820, the odds for the drive to result in a touchdown are already stored, so the next possibility may be for the drive to result in a field goal. For example, if the Patriots had 100 drives with two minutes remaining in the first half versus the New York Jets and out of those 100 drives only ten times did the drive result in a field goal, then there may only be a 10% chance for the drive to result in a field goal, which the odds may be 100:10 or displayed to the user as 10:1 odds for the drive to result in a field goal. Since the predetermined number of possibilities is set at seven, then the drive begins module 38826 may repeat this loop until the odds are calculated for the drive to result in a touchdown, field goal, three and out, interception, fumble, five plays, or six plays. In some embodiments, the predetermined number of possibilities may be set at any number, and seven is only used as an example. If there are enough odds created for the predetermined number of possibilities for the drive results, then the drive begins module 38826 may send, at step 39020, the drive result wager odds to the wagering app 38810. For example, the drive result odds that are sent to the wagering app 38810 may be that the New England Patriots drive ends with a touchdown, at 20:1 odds, results in a field goal, at 10:1 odds, results in a three and out, at 5:1 odds, etc. Then the drive begins module 38826 may return, at step 39022, to the base module 38824.

FIG. 391 illustrates the drive continuation module 38828. The process may begin with the drive continuation module 38828 being initiated, at step 39100, by the base module 38824. Then the drive continuation module 38828 may compare, at step 39102, the upcoming play data to the odds database 38820. For example, the drive continuation module 138828 may compare the date of the event, the time of the event, the teams playing, the time within the event, and the players in the event to determine if there are current drive result odds available. For example, if the date is Sep. 8, 2020, the time of the event is 2:15 pm EST, the teams playing are the New England Patriots vs. the New York Jets, the time within the event is one minute and 50 seconds remaining, and the Patriots have possession of the ball at the New England 35-yard line then the odds database 38820 may contain the record of drive result odds created during the process described in the drive begins module 38826. The drive continuation module 38828 may determine, at step 39104, if there is an existing drive wager odds for the upcoming play. For example, the drive continuation module 38828 may compare the date of the event, the time of the event, the teams playing, the time within the event, and the players in the event to determine if there are current drive wager or drive results odds available. For example, if the date is Sep. 8, 2020, the time of the event is 2:15 pm EST, the teams playing are the New England Patriots vs. the New York Jets, the time within the event is the two minutes remaining, and the Patriots have possession of the ball at the New England 25-yard line then the odds database 38820 may contain the record of drive result odds created during the process described in the drive begins module 38826. If there are no drive wager odds available in the odds database 38820, then the drive continuation module 38828 may return, at step 39106, to the base module 38824. For example, the drive continuation module 38828 may return to the base module 38824 to create the first drive result odds or drive wager odds. If there are drive result odds available in the odds database 38820, then the drive continuation module 38828 may extract, at step 39108, the sequence odds from the odds database 38820. For example, the data extracted may be the date is Sep. 8, 2020, the time of the event is 2:15 pm EST, the teams playing are the New England Patriots vs. the New York Jets, the time within the event is two minutes remaining, and the Patriots have the ball at the New England 25 yard line, with the drive result odds of the drive resulting in a touchdown, at 20:1 odds, resulting in a field goal, at 10:1 odds, resulting in a three and out, at 5:1 odds, etc. Then the drive continuation module 38828 may determine, at step 39110, if odds are created for the predetermined number of possibilities in the drive result. For example, a first down has occurred, so the odds of 5:1 for the drive to result in a three and out may no longer be available to the user and thus removed from the drive result odds, this may result in the drive result odds only containing six possibilities, and that may not meet the predetermined threshold of seven possibilities and the corresponding odds. If there are not enough odds created for the predetermined number of possibilities for the drive result odds, then the drive continuation module 38828 may filter, at step 39112, the historical plays database 38818 on the upcoming play data. For example, the historical plays database 38818 may be filtered for the New England Patriots vs. New York Jets event is in the second quarter with one minute and 50 seconds remaining, with New England having possession of the ball on the New England 35-yard line with a first down and ten yards to go. Then the drive continuation module 38828 may extract, at step 39114, the data from the historical plays database 38818. For example, the drive continuation module 38826 may extract all the historical wagering odds data associated with the event being the New England Patriots vs. New York Jets event is in the second quarter with one minute and 50 seconds remaining, with New England having possession of the ball on the New England 35-yard line with a first down and ten yards to go. The drive continuation module 38828 may determine, at step 39116, the wager odds for the next possibility for the drive results odds. For example, the odds for the drive to result in a touchdown, field goal, interception, fumble, five plays, and six plays may be stored in the odds database, so the drive continuation module may need to calculate the odds for the drive resulting in only seven plays. For example, if the Patriots had 100 drives versus the New York Jets and out of those 100 drives only once did the drive result in only seven plays, then there may only be a 1% chance for the drive to last seven plays, which the odds may be 100:1 or displayed to the user as 100:1 odds for the drive to last seven plays. In some embodiments, the drive results odds may be determined for the offensive team to achieve a first down and then from that first down perform three plays and punt. In some embodiments, the drive result odds may be recalculated using the same method for all drive result possibilities, such as touchdown, field goal, interception, fumble, five plays, and six plays. In some embodiments, the drive result odds may be recalculated on a play-by-play basis to calculate more accurate wagering odds. Then the drive continuation module 38828 may store, at step 39118, the drive result wager odds in the odds database 38820. For example, the 100:1 odds for the drive to last seven plays may be stored with the current drive result odds in the odds database 38822. If there are enough odds created for the predetermined number of possibilities for the drive results, then the drive continuation module 38828 may send, at step 39120, the drive result wager odds to the wagering app 38810, and the process may return to the drive continuation module 38828 returning to the base module 38824. For example, the drive result odds that are sent to the wagering app 38810 may that the New England Patriots drive resulting in a touchdown, at 20:1 odds, resulting in a field goal, at 10:1 odds, up to the drive lasting seven plays, at 100:1 odds.

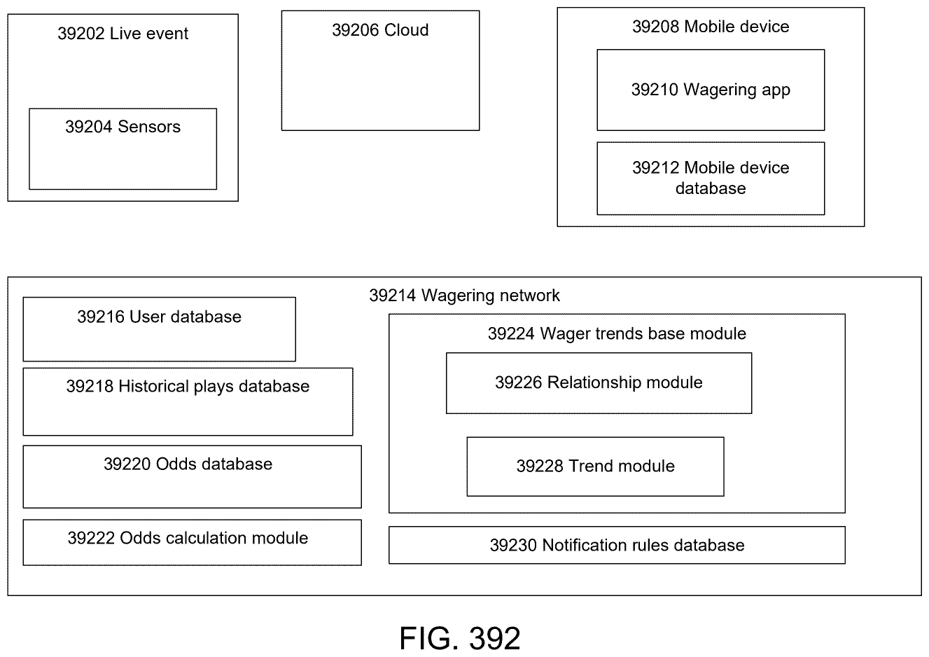

FIG. 392 illustrates a system for providing a user with betting statistics, according to an embodiment.

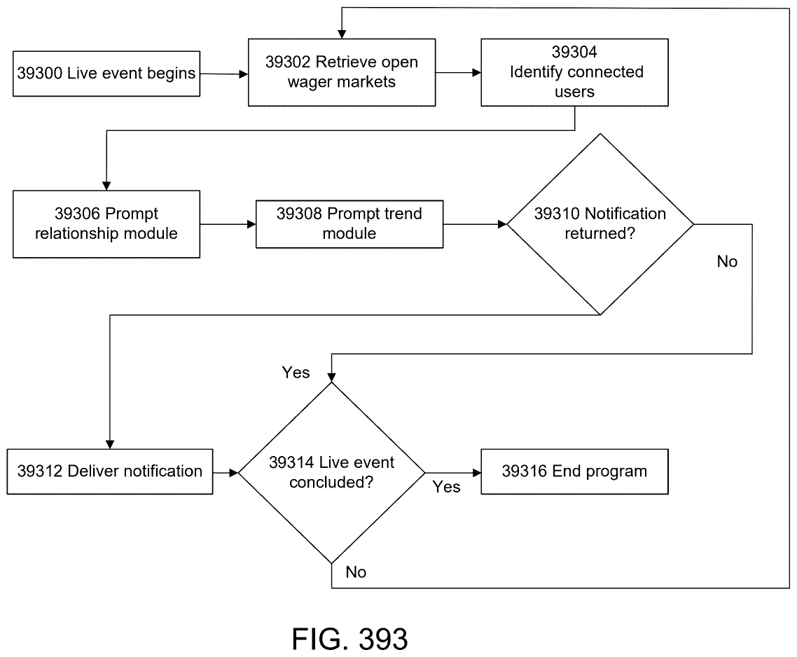

FIG. 393 illustrates a wager trends base module, according to an embodiment.

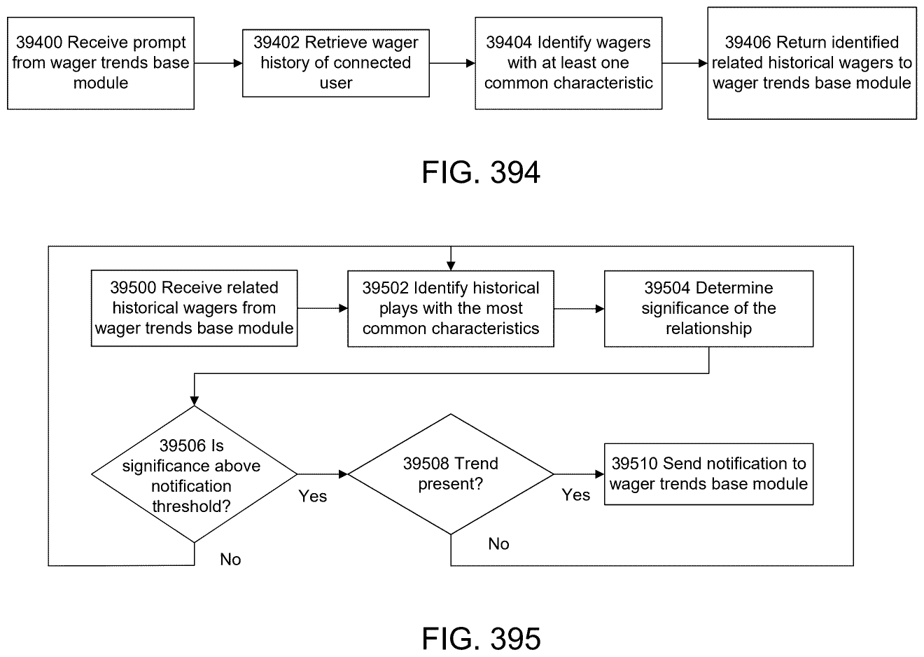

FIG. 394 illustrates a relationship module, according to an embodiment.

FIG. 395 illustrates a trend module, according to an embodiment.

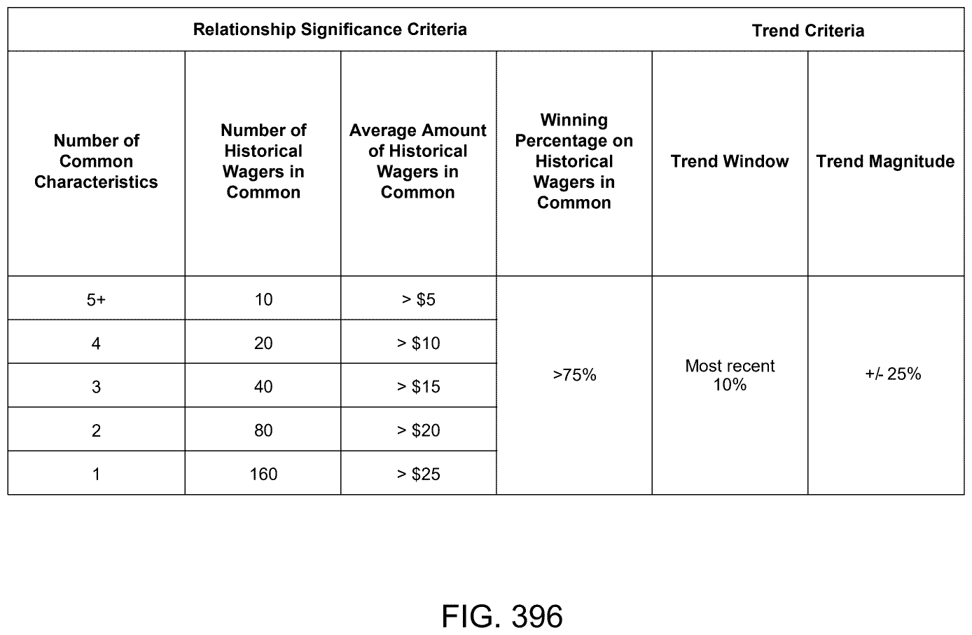

FIG. 396 illustrates a notification rules database, according to an embodiment.

FIG. 392 is a system for providing a user with betting statistics. This system may include a live event 39202, for example, a sporting event such as a football, basketball, baseball, or hockey game, tennis match, golf tournament, eSports, or digital game, etc. The live event 39202 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 39202, such as the score of an American football game or the run line in a baseball game, or a series of actions in the live event 39202. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 39202 or at another location.

Further, embodiments may include a plurality of sensors 39204 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 39204 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 39206 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 39206 may be communicatively coupled to a peer-to-peer wagering network 39214, which may perform real-time analysis on the type of play and the result of the play. The cloud 39206 may also be synchronized with game situational data such as the time of the game, the score, location on the field, weather conditions, and the like, which may affect the choice of play utilized. For example, in an exemplary embodiment, the cloud 39206 may not receive data gathered from the sensors 39204 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 39208 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras

(SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, Fire Wire, Ethernet, Gigabit Ethernet, Fiber Channel, or Thunderbolt buses. In some embodiments, the mobile device 39208 could be an optional component and would be utilized in a situation where a paired wearable device employs the mobile device 39208 for additional memory or computing power or connection to the internet.

Further, embodiments may include a wagering software application or a wagering app 39210, which is a program that enables the user to place bets on individual plays in the live event 39202, streams audio and video from the live event 39202, and features the available wagers from the live event 39202 on the mobile device 39208. The wagering app 39210 allows the user to interact with the wagering network 39214 to place bets and provide payment/receive funds based on wager outcomes.

Further, embodiments may include a mobile device database 39212 that may store some or all the user's data, the live event 39202, or the user's interaction with the wagering network 39214.

Further, embodiments may include the wagering network 39214, which may perform real-time analysis on the type of play and the result of a play or action. The wagering network 39214 (or the cloud 39206) may also be synchronized with game situational data, such as the time of the game, the score, location on the field, weather conditions, and the like, which may affect the choice of play utilized. For example, in an exemplary embodiment, the wagering network 39214 may not receive data gathered from the sensors 39204 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 39214 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 39216, which may contain data relevant to all users of the wagering network 39214 and may include, but is not limited to, a user ID, a device identifier, a paired device identifier, wagering history, or wallet information for the user. The user database 39216 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 39216 may contain betting lines and search queries. The user database 39216 may be searched based on a search criterion received from the user. Each betting line may include but is not limited to, a plurality of betting attributes such as at least one of the following: the live event 39202, a team, a player, an amount of wager, etc. The user database 39216 may include, but is not limited to, information related to all the users involved in the live event 39202. In one exemplary embodiment, the user database 39216 may include information for generating a user authenticity report and a wagering verification report. Further, the user database 39216 may be used to store user statistics like, but not limited to, the retention period for a particular user, frequency of wagers placed by a particular user, the average amount of wager placed by each user, etc.

Further, embodiments may include a historical plays database 39218 that may contain play data for the type of sport being played in the live event 39202. For example, in American Football, for optimal odds calculation, the historical play data may include metadata about the historical plays, such as time, location, weather, previous plays, opponent, physiological data, etc.

Further, embodiments may utilize an odds database 39220—that may contain the odds calculated by an odds calculation module 39222—to display the odds on the user's mobile device 39208 and take bets from the user through the mobile device wagering app 39210.

Further, embodiments may include the odds calculation module 39222, which may utilize historical play data to calculate odds for in-play wagers.

Further, embodiments may include a wager trends base module 39224, which may present the user with information related to characteristics, trends within those characteristics, and their wagering history related to at least one open wagering market on the current play in the live event 39202. The wager trends base module 39224 may prompt the relationship module 39226 when a user is connected to the wagering network 39214, and at least one wagering market is open in the odds database 39220. The relationship module 39226 may return related characteristics of the open wagering markets to characteristics of the user's wagering history. The characteristics of the open wagering market may include one or more of the teams involved, the down, distance, position on the field, one or more players involved in the current play, the score, the time remaining, the weather, etc. For example, it may be 3rd and three, with 1:50 to go in the second quarter the American football game between the Detroit Lions and the Green Bay Packers, with the Packers on offense, and the open wagering market is on the play being a run versus a pass. The relationship module 39226 may return the wagering history for the user related to wagers on the Packers, wagers in the last two minutes of a half, wagers on the play being a run versus a pass, wagers involving Aaron Rogers at quarterback, etc. The received relationship may then be sent to the trend module 39228 to determine the significance of the relationship between the characteristics of the wagering market and the characteristics of the user's wager history. The significance of the relationship may be based on the amount of money wagered on a wagering market with at least one shared characteristic of the current wagering market. The relationship may also be based on the number of wagers, the timing of wagers, the pattern of wagers, etc. Suppose the relationship between the user's wagering history and the current wagering market is above a threshold. In that case, a notification may be sent to the user indicating a statistic or trend in their wagering history is related to the current wagering market. The notification may be provided in the form of displayed information, sound or audio information, or haptics information, as desired. For example, the user may be notified that they have won 70% of wagers they have made on a pass inside the last two minutes of a half.

Further, embodiments may include a relationship module 39226, which may identify characteristics of the current wagering market and retrieve from the user database 39216 any of the historical wagers made by the current user that have at least one characteristic in common with the current wagering market. The identified related wagers may then be sent to the wager trends base module 39224.

Further, embodiments may include a trend module 39228, which may determine the significance of the relationship between the identified historical wagers of the current user and the current wagering market.

Further, embodiments may include a notification rules database 39230, which may contain the criteria in which a notification containing data related to their wagering history's relationship to the current wagering market may be delivered to a user.

FIG. 393 illustrates the wager trends base module 39224. The process may begin with the live event 39202 beginning at step 39300. The open wagering markets may then be retrieved at step 39302 from the odds database 39220. The users connected to the wagering network 39214 may be identified at step 39304. The relationship module 39226 may then be prompted at step 39306. Once the relationship module 39226 has returned some number of historical wagers by the user with at least one characteristic in common with the currently open wagering market, the trend module 39228 may be prompted at step 39308. The wager trends base module 39224 may determine, at step 39310, if a notification has been returned by the trend module 39228. If no notification was returned, the process may proceed to step 39314. If a notification was received at step 39310, that notification may be delivered at step 39312 to the user's mobile device 39208. This notification may be in the form of a pop-up or banner in the wagering app 39210. The notification may include the user's historical winning percentage on similar wagers displayed next to a given wagering option. For example, the user may be shown that they have a won 80% of the wagers they have made on the Green Bay Packers passing on a play that takes place in their opponent's red zone with less than two minutes to go in a half. The notification may also include representing a trend in the identified historic wagers similar to the current wagering market. For example, the user may have only a 34% winning percentage on historically similar wagers, but their last five such wagers have a 60% winning percentage. This trend in results may be represented as a green upwards-facing arrow. The size, shade, movement, or shape of the representation may vary based on the wager type, the magnitude of the trend, the sample size, etc. The wager trends base module 39224 may determine at step 39314 if the live event 39202 has concluded. If the live event 39202 has not concluded, the process may return to step 39302. If the live event 39202 has concluded, the process may end at step 39316.

FIG. 394 illustrates the relationship module 39226. The process may begin with the relationship module 39226 receiving, at step 39400, a prompt from the wager trends base module 39224 indicating there is at least one user connected to the wagering network 39214 and there is at least one currently open wagering market in the odds database 39220. The relationship module 39226 may retrieve, at step 39402, the identified connected user(s) wagering history from the user database 39216. The relationship module 39226 may identify, at step 39404, wagers made by the identified user with at least one characteristic in common with the currently open wagering market. For example, related wagers may be previous wagers made on the Green Bay Packers passing plays, wagers made on plays that takes place in their opponent's red zone, wagers made on plays with less than two minutes to go in a half. The relationship module 39226 may return, at step 39406, related historical wagers to the wagering trends base module 39224.

FIG. 395 illustrates the trend module 39228. The process may begin with the trend module 39228 receiving from the wager trends base module 39224, at step 39500, historical wagers of a user that share at least one characteristic in common with the current wagering market. The trend module 39228 may then identify, at step 39502, a cohort of historical wagers with the greatest number of characteristics in common with the current wagering market. For example, the open wagering market is on the play being a run versus a pass on a 3rd and three, with 1:50 to go in the second quarter of an American football game between the Detroit Lions and the Green Bay Packers, with the Packers on offense at the Detroit 15-yard line. A cohort of related wagers may be the historical wagers by the user that were wagered on the play being a pass, for an amount between five and ten dollars, with less than two minutes left in the half, inside the 20-yard line, involving the Packers' offense, the Lions' defense, with Aaron Rogers at Quarterback, between seventy- and eighty-degrees Fahrenheit, with the Packers' trailing in the game by between three and five points. It should be obvious that these are non-limiting examples of characteristics of the play and wager. Characteristics may also include physiological data related to players, telemetry on players, or other related game elements such as the ball, pylon, officials, etc., and characteristics of the wager related to a pattern of wagers. For example, wagers made after a lost wager, wagers made after winning the previous three wagers, etc. The trend module 39228 may determine, at step 39504, the significance of the relationship between the cohort of identified historical wagers and the current wagering market. The significance of the relationship between the cohort of identified historical wagers and the current wagering market may be the number of common characteristics. For example, a first cohort of historical wagers with two common characteristics may be wagers made on plays that take place in their opponent's red zone and less than two minutes to go in a half. A second cohort of wagers with three common characteristics may be wagers made on plays that takes place in their opponent's red zone and less than two minutes to go in a half, and involve the Green Bay Packers offense. The relationship of the second cohort of plays to the current play may be considered more significant because there are more common characteristics. In another embodiment, the significance of the specificity of the relationship between the characteristics may be used to determine the significance of the relationship. For example, a first common characteristic may be all wagers on plays in the red zone. The red zone is a common American football term for the field inside the opponent's 20-yard line. A second common characteristic may be all plays in the red zone may be all wagers on plays on the 15-yard line exactly. A cohort of plays that took place on the 15-yard line may be considered to have a stronger relationship to the current play than a larger cohort of plays that include all plays inside the 20-yard line. The larger the sample size of historical wagers the system has to evaluate, the more specific the characteristic filter may be. An administrator may set these thresholds, or they may be dynamically determined. For example, an administrator may define one common characteristic as plays inside of the red zone. The system may learn over time that wagers on plays that take place between the opponent's 5-yard line and 20-yard line have many other common characteristics but plays between the goal line and the 5-yard line are related to different types of wagering behavior, either in an individual user or a cohort of users. The trend module 39228 may then determine, at step 39506, if the significance of the relationship is above a threshold for notification. The significance of the relationship may be determined by comparing the characteristics of the current cohort of wagers to the criteria in the notification rules database 39230. In the present example, the identified cohort may fall into a significance level defined by an administrator as historical wagers with five or more characteristics in common with the currently open wagering market. The first notification threshold in this example may be based on the number of wagers in the cohort. A threshold for significance in the current example may be at least ten historical wagers in the cohort with five common characteristics. If the cohort being examined does not meet the minimum number of similar historical wagers, the process may return to step 39502 until there is a notification to deliver, or there are no more cohorts to examine. There may be multiple criteria for significance, such as the number of wagers, average wager amount, wager frequency, etc. For example, the trend module 39228 may determine that the user has made 50 historic wagers on the Packers passing on plays inside the red zone with less than two minutes to go in the half (four common characteristics) with an average wager amount of $25. These values may be above the relationship significance thresholds for both the number of common characteristics and the average wager amount. When a cohort of historical wagers has been determined to have a relationship with the currently open wagering market above at least one significance threshold, the trend module 39228 may then determine, at step 39508, if there is a trend present in the identified cohort of historical wagers. One way to identify a trend may be to compare statistics about the entirety of the identified cohort of wagers, such as winning percentage, average wager size, frequency, etc., to those same statistics against a more recent subset of wagers in the cohort. For example, the user's winning percentage on the 50 wagers in the identified cohort of wagers on the Packers passing inside the red zone with less than two minutes remaining in the half may be 80%. This winning percentage may be above the threshold for notification in the notification rules database 39230. The user may be delivered a notification of their winning percentage on similar historical wagers to incentivize them to wager on the currently open wagering market or incentivize them to increase their wager by informing them of their past success in these similar types of wagering markets. The user may have a low winning percentage, 30%, on the identified cohort of wagers. In some embodiments, this low of a winning percentage may be criteria for notification to inform the user of wagering markets in which they have historically performed poorly. In the present example, the most recent 10% of wagers in a cohort are compared to the other 90% of wagers to determine if there is a trend present in the cohort of wagers. Keeping with the example of winning percentage as the statistic being examined in the cohort of identified wagers, the user's winning percentage on the identified cohort of 50 wagers is 34% or 17/50. This winning percentage may not be above the threshold for notification in the notification rules database 39230. However, the user's winning percentage on the five most recent wagers (60%) in the identified cohort may be compared to the user's winning percentage in the other forty-five wagers (31%). Their recent wagers resulted in a +29% increase in the user's winning percentage, above the threshold for notification in the notification rules database 39230. One or more identified notifications may then be sent at step 39510 to the wager trends base module 39224.

FIG. 396 illustrates the notification rules database 39230. The database may contain the criteria for sending a notification to the user regarding a cohort of the user's historic wagers similar to some characteristics of one or more currently open wagering markets. The database may contain several thresholds for the significance of the relationship between the currently open wagering market and the identified cohort of historic wagers. These criteria may include the number of characteristics the identified cohort has in common with the current market, the average amount of the wager, the number of wagers in the identified cohort, winning percentage on the identified wagers, etc. In some embodiments, the relationship significance criteria may be combined. For example, a cohort with five or more characteristics in common with the currently open wagering market may require only ten wagers in the cohort or have an average wager amount greater than five dollars to meet the criteria for a notification to be delivered to the user. At the same time, a cohort with only three characteristics in common with the currently open wagering market may require at least forty wagers to be in the cohort or have an average wager amount greater than fifteen dollars. In the present example, the criteria are static and set by an administrator. The criteria may also be specific to a given user or a cohort of similar users. The criteria may adjust dynamically based on an algorithm examining the users' wagering behavior and their response to the notifications delivered. For example, the system may identify that one cohort of users wagers more when they receive notifications related to wagers with more common characteristics. Another cohort of users wagers more when they receive notifications related to large sample sizes of wagers with fewer characteristics in common with the current wagering market. The notification rules database 39230 may also contain notification criteria related to trends identified in a cohort of wagers similar to the current wagering market. The winning percentage on a recent subset of the identified cohort may be compared to the rest of the cohort. For example, the user may receive a notification when they have a winning percentage on the most recent ten percent of wagers in the identified cohort that is at least twenty-five percent higher than the other ninety percent of the identified cohort. The criteria for a notification to be delivered due to an identified trend may be set by an administrator, be specific to users or cohorts of users, and/or be dynamically determined by an algorithm.

FIG. 397 illustrates a system for providing a user with bet-related information prior to placing a real-time bet, according to an embodiment.

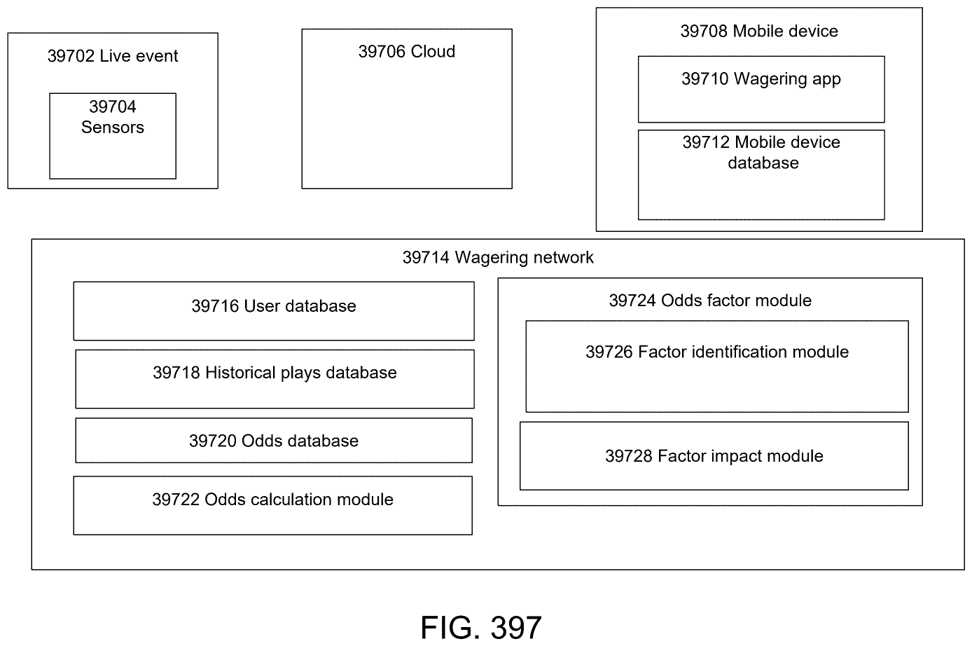

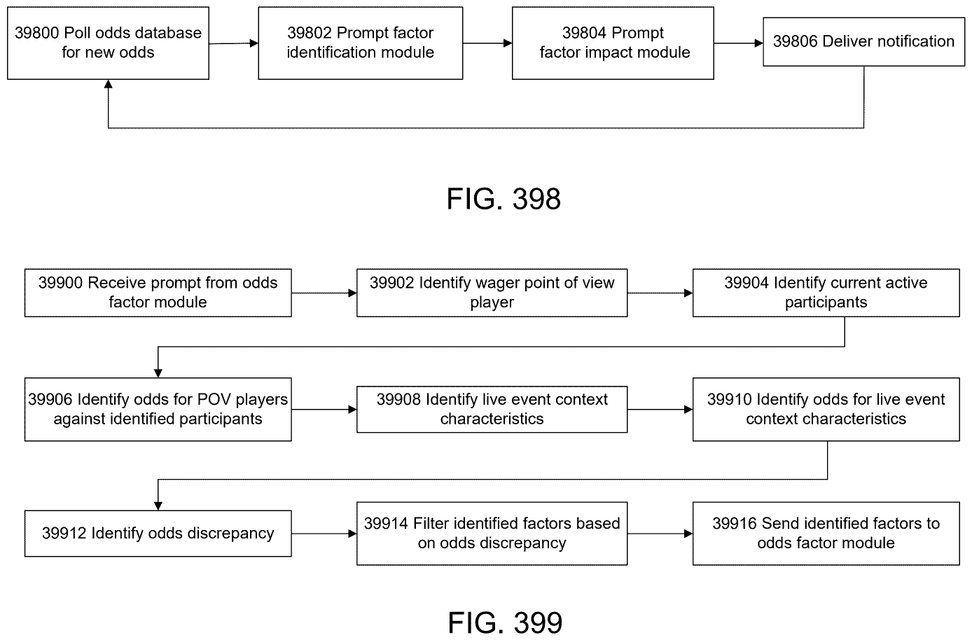

FIG. 398 illustrates an odds factor module, according to an embodiment.

FIG. 399 illustrates a factor identification module, according to an embodiment.

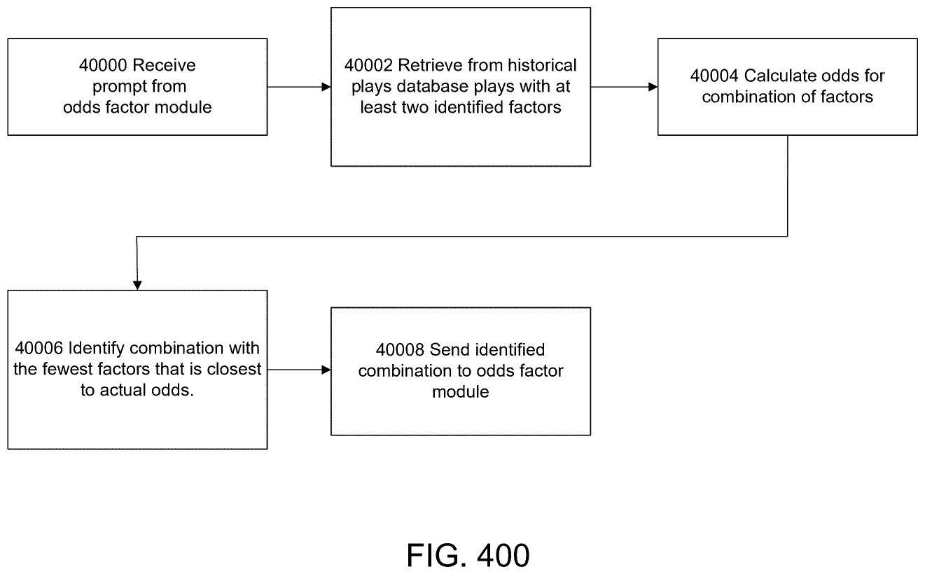

FIG. 400 illustrates a factor impact module, according to an embodiment.

FIG. 397 is a system for providing a user with bet-related information prior to placing a real-time bet. This system may include a live event 39702, for example, a sporting event such as a football, basketball, baseball, or hockey game, tennis match, golf tournament, eSports, or digital game, etc. The live event 39702 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 39702, such as the score of an American football game or the run line in a baseball game, or a series of actions in the live event 39702. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 39702 or at another location.

Further, embodiments may include a plurality of sensors 39704 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 39704 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 39706 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 39706 may be communicatively coupled to a peer-to-peer wagering network 39714, which may perform real-time analysis on the type of play and the result of the play. The cloud 39706 may also be synchronized with game situational data such as the time of the game, the score, location on the field, weather conditions, and the like, which may affect the choice of play utilized. For example, in an exemplary embodiment, the cloud 39706 may not receive data gathered from the sensors 39704 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 39708 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 39708 could be an optional component and would be utilized in a situation where a paired wearable device employs the mobile device 39708 for additional memory or computing power or connection to the internet.

Further, embodiments may include a wagering software application or a wagering app 39710, which is a program that enables the user to place bets on individual plays in the live event 39702, streams audio and video from the live event 39702, and features the available wagers from the live event 39702 on the mobile device 39708. The wagering app 39710 allows the user to interact with the wagering network 39714 to place bets and provide payment/receive funds based on wager outcomes.

Further, embodiments may include a mobile device database 39712 that may store some or all the user's data, the live event 39702, or the user's interaction with the wagering network 39714.

Further, embodiments may include the wagering network 39714, which may perform real-time analysis on the type of play and the result of a play or action. The wagering network 39714 (or the cloud 39706) may also be synchronized with game situational data, such as the time of the game, the score, location on the field, weather conditions, and the like, which may affect the choice of play utilized. For example, in an exemplary embodiment, the wagering network 39714 may not receive data gathered from the sensors 39704 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 39714 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 39716, which may contain data relevant to all users of the wagering network 39714 and may include, but is not limited to, a user ID, a device identifier, a paired device identifier, wagering history, or wallet information for the user. The user database 39716 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 39716 may contain betting lines and search queries. The user database 39716 may be searched based on a search criterion received from the user. Each betting line may include but is not limited to, a plurality of betting attributes such as at least one of the following: the live event 39702, a team, a player, an amount of wager, etc. The user database 39716 may include, but is not limited to, information related to all the users involved in the live event 39702. In one exemplary embodiment, the user database 39716 may include information for generating a user authenticity report and a wagering verification report. Further, the user database 39716 may be used to store user statistics like, but not limited to, the retention period for a particular user, frequency of wagers placed by a particular user, the average amount of wager placed by each user, etc.

Further, embodiments may include a historical plays database 39718 that may contain play data for the type of sport being played in the live event 39702. For example, in American Football, for optimal odds calculation, the historical play data may include metadata about the historical plays, such as time, location, weather, previous plays, opponent, physiological data, etc.

Further, embodiments may utilize an odds database 39720—that may contain the odds calculated by an odds calculation module 39722—to display the odds on the user's mobile device 39708 and take bets from the user through the mobile device wagering app 39710.

Further, embodiments may include the odds calculation module 39722, which may utilize historical play data to calculate odds for in-play wagers.

Further, embodiments may include an odds factor module 39724, which may communicate to the user contextual factors for a given wagering market that may impact the odds. For example, when the new odds are available in the odds database 39720, the odds factor module 39724 may call a factor identification module 39726 to identify contextual characteristics that impact the odds. Then a factor impact module 39728 may be called to determine the relative impact of each identified factor on the odds for a given wagering market.

Further, embodiments may include the factor identification module 39726, which may identify one or more context characteristics of the live event 39702 that may impact the odds for a given wagering market. For example, the odds of a baseball player with a 0.300 batting average getting a hit in a given at-bat may be expected to +235. +235 is the money line equivalent of a 30% chance. However, the odds being offered by the wagering network 39714 of the batter getting a hit in the current at-bat are +300, which corresponds to a 25% chance of an event happening. The factor identification module 39726 may identify characteristics, or combinations of characteristics, of the current wagering market that may be contributing to the discrepancy in the expected odds and the actual odds. These factors may include the players involved, the weather, the location of the live event 39702, the score, the position of other participants in the live event 39702, recent trends in performance, etc.

Further, embodiments may include the factor impact module 39728, which may identify the magnitude of impact a given contextual characteristic may have on the odds in the current wagering market. For example, the odds of a baseball player with a 0.300 batting average getting a hit in a given at-bat may be expected to +235. +235 is the money line equivalent of a 30% chance. The odds being offered by the wagering network 39714 of the batter getting a hit in the current at-bat are +300, which corresponds to a 25% chance of an event. Potential contextual characteristics of the live event 39702 that may factor into the current odds may include the position of another participant, such as a runner on second base, the weather, such as light rain, and the location of the game, a home game. The factor impact module 39728 may determine that having a runner on second base may increase the odds of a walk, thus lowering the odds of a hit. It may also identify that having light rain may correspond to a 10% increase in the pitcher's walk rate. The relative impact of one or more factors may then be communicated to the user.

FIG. 398 illustrates the odds factor module 39724. The process may begin with the odds factor module 39724 polling, at step 39800, the odds database 39720 for odds available on an open wagering market. For example, when a batter comes up to bat, the odds calculation module 39722 may have a wagering market on the batter getting a hit and offer odds of +400 on that outcome. The odds factor module 39724 may prompt, at step 39802, the factor identification module 39726. The factor identification module 39726 may return contextual characteristics of the live event 39702 that may be factored in the odds. The odds factor module 39724 may prompt, at step 39804, the factor impact module 39728. The factor impact module 39728 may return a weighted list of factors that may impact the odds. A notification related to some or all the weighted list of factors may be delivered at step 39806 to one or more users connected to the wagering network 39714. For example, the odds being offered for Aaron Judge to get a hit in his current at-bat against Clayton Kershaw may be +400. If Aaron Judge has a. 300 batting average, meaning he gets a hit 30% of the time, the odds offered of him getting a hit may be +230. The factor identification module 39726 may identify several characteristics of the live event 39702 that may be factored in the probability of Aaron Judge getting a hit in this at-bat being +400, representing an outcome having a 20% probability. The identified factors may be the pitcher being left-handed, runners on second and third base, one out in the inning, and the weather, including light precipitation. The factor impact module 39728 may identify the position of the runners on base and the number of outs in the inning as the largest contributors to the decrease in the probability of Aaron Judge getting a hit in the current at-bat. In this example, these contextual characteristics may impact the odds because the odds of a walk increase due to a commonly known baseball strategy to walk a batter in these circumstances and set up a double play. The notification to the user may be in many forms. In one example, the user may be viewing the multiple available wagers on the current at-bat. The notification may highlight the “hit” wagering market with a red box or arrow, while the “walk” wagering market may be highlighted with a green box or arrow. The notification may demonstrate that the increased odds of a walk are suppressing the odds of getting a hit. The notification may include one or more factors not represented in a wagering market in another exemplary embodiment. For example, the sensors 39704 may collect data related to the pitches being thrown, such as spin rate, vertical break, horizontal break, release point, etc. Characteristics provided by a third party may include information such as weather data, scouting reports, batting order, injury reports, etc. Notifications related to factors that are not wagering markets may be represented to the user as a pop-up, banner, ticker, or other added content. The notification may be a graphical representation of the factor. For example, rain falling may be shown to be depressing the odds of the batter getting a hit. Representations of performance data, such as a pitcher's spin rate or release point, may be represented on the wagering screen. For example, the sensor data may indicate the pitcher's release point has been more inconsistent in the current live event 39702 than in the plays retrieved from the historical plays database 39718. This information may be delivered to the user by illustrating a circle around the range of release points in the current live event 39702, overlayed with a smaller circle representing the historical range of the pitcher's release points. Inconsistency in a pitcher's release point is often highly correlated with a decrease in the pitcher's command of his pitches, which may increase the probability of a walk. A pitcher's average spin rate in the current live event 39702 may be higher than normal, which may also decrease the probability of the batter getting a hit. A higher spin rate on a given pitch type is often highly correlated with more swing-and-miss strikes and weaker contact, as indicated by diminished exit velocities. A rotating baseball may be depicted with the variance between the pitcher's historical average spin rates and their spin rates in the current live event 39702. Any number of factors may be included in a notification. For example, the user may be shown that the open base at first increases the odds of a walk, and the increased spin rate decreases the odds of a hit, and the increased variation in release the pitcher's release point also increases the odds of a walk and diminishes the odds of a hit. In another embodiment, the relative impact of multiple factors on the probability of an outcome in the current wagering market may be included in the notification. For example, if three factors identified as impacting the odds of the current wagering market were the pitcher's increased spin rate, the pitcher's decrease in the consistency of his release point, and the position of the runners on base, it may be determined that the position of the runners account for 80% of the decrease in the odds for a hit, while the pitcher's release point inconsistency accounts for 15% of the decrease in odds, and the pitcher's increase in spin rate accounts for 5% of the decrease in the odds. The relative impact of these factors may be represented as alphanumeric. The relative impact may also be represented by the relative size, magnitude, intensity, or motion, of each visual representation of the factor. For example, the factor with the most impact on the odds change may be listed first in a list or proportionally larger than the other text or image. The process may then return to step 39800.

FIG. 399 illustrates the factor identification module 39726. The process may begin with the factor identification module 39726 receiving, at step 39900, a prompt from the odds factor module 39724 indicating there are odds available on a currently open wagering market for a sub-outcome of the live event 39702. For example, there may be odds of +400 available to wager on Aaron Judge getting a hit in the current at-bat of the live event 39702. A sub-outcome may be any play, portion of a play, or combination of plays in the live event 39702 that are not the conclusion of the live event 39702. For example, a pitch, at-bat, or inning, a baseball game, a play, drive, quarter, or half in an American football game. The factor identification module 39726 may identify, at step 39902, the point-of-view player for the currently open wagering market. The point-of-view player may be the player on whom the user has wagered. For example, if the user wagered Aaron Judge to get a hit in his current at-bat, Aaron Judge may be the point-of-view player for that wagering market. Some sub-outcomes may have more than one potential point-of-view player. For example, a user could wager on a strikeout in the current at-bat. The point-of—view player may be batter, as in “I bet that Aaron Judge strikes out.” The point-of-view player may also be the pitcher, as in “I bet Clayton Kershaw strikes this guy out.” For cases in which there may be multiple potential point-of-view players, the point-of-view player may be identified by the phrasing of the wager. The point-of-view player may also be personalized to the user based on their preferences, wagering history, or other characteristics. For example, a Dodgers fan or a user geolocated in Los Angeles may have the pitcher assigned as the point-of-view player in their wagering app 39710 and because the pitcher is on the Los Angeles Dodgers the system may assume their preference of team. The factor identification module 39726 may identify, at step 39904, current active participants in the live event 39702 that are not the point-of-view players for the currently open wagering market. Suppose the point-of-view player is the batter. Participants in the live event 39702 that are not the point-of-view player may include the pitcher, defenders, runners on base, potential relief pitchers, potential pinch hitters, managers, coaches, officials, etc. The factor identification module 39726 may identify, at step 39906, the odds for the point-of-view player identified against other participants that may be identified. For example, the odds of the batter getting a hit off of the current pitcher or a cohort of similar pitchers may be calculated. The odds of the batter, or a cohort of similar batters, getting a hit with runners on second and third and one out may be calculated. This process of calculating odds may be repeated for any other active participants or a combination of active participants. The factor identification module 39726 may identify, at step 39908, contextual characteristics of the live event 39702. Contextual characteristics of the live event 39702 may include the location, weather, score, league standings, playoff standings, playoff position, player biometrics, etc. The factor identification module 39726 may identify, at step 39910, odds for the contextual characteristics of the live event 39702. For example, the odds may be determined for the batter, who is the point-of-view player, getting a hit in similar weather in the current ballpark, during a similar period, against a specific defensive alignment, the same officials, etc. It should be obvious that the odds of a given outcome may be calculated involving a combination of these factors and the other active participants in the live event 39702. The factor identification module 39726 may identify, at step 39912, any discrepancy between the odds on an outcome in the odds database 39720 and the odds of the point-of-view player having that same outcome in the absence of any context characteristic or participant-based factors. For example, Aaron Judge may get a hit in 30% of his plate appearances when considering the entire season. The odds being offered may reflect only a 20% chance of Aaron Judge getting a hit in the current context of the live event 39702. The difference between the 30% expected odds and the 20% offered odds represents the discrepancy of −10%. The factor identification module 39726 may filter, at step 39914, the identified factors to include the factors that may have the same directional impact on the odds. For example, Aaron Judge may have a lower chance of getting a hit with a runner on second base and first base open than some larger sample size of his at-bats. Other factors that may harm the odds of Aaron Judge getting a hit in the current at-bat may include increased spin rate by the pitcher, a larger or more inconsistent strike zone being called by the current umpire, first base being open with a runner in scoring position and less than two outs, a right-handed pitcher pitching, weather that impacts the pitcher's command of their pitches, a defensive shift, etc. Factors that may positively impact the odds of Aaron Judge getting a hit may include decreased spin rate by the pitcher, the bases being loaded, a left-handed pitcher pitching, etc. Factors that have the opposite impact of the identified discrepancy may be discarded. The factor identification module 39726 may send, at step 39916, the remaining identified factors that have the same directional impact on the odds as the identified discrepancy to the odds factor module 39724.

FIG. 400 illustrates the factor impact module 39728. The process may begin with the factor impact module 39728 receiving, at step 40000, a prompt from the odds factor module 39724 that may include at least one factor that may be influencing the odds on a currently open wagering market. For example, the odds being offered for Aaron Judge to get a hit in his current at-bat against Clayton Kershaw may be +400. If Aaron Judge has a 0.300 batting average, meaning he gets a hit 30% of the time, the odds offered for him getting a hit may be +230. The factor identification module 39726 may identify several characteristics of the live event 39702 that may be factored in the probability of Aaron Judge getting a hit in this at-bat being +400, representing an outcome having a 20% probability. The identified factors may be the pitcher being left-handed, the pitcher's spin rate being 100 rpm higher than his average, runners being on second base and third base, the number of outs in the inning being one, and the weather including light precipitation. The factor identification module 39726 may identify the position of the runners on base and the number of outs in the inning, the light precipitation, and the increase in the pitcher's average spin rate as the factors that contribute to the decrease in the probability of Aaron Judge getting a hit in the current at-bat. The factor impact module 39728 may retrieve, at step 40002, historical plays involving the current point-of-view player, or a cohort of similar players, and at least two of the identified factors from the historical plays database 39718. For example, plays with Aaron Judge batting with first base open, one out, and light rain. The factor impact module 39728 may calculate, at step 40004, the odds of the outcome that is the subject of the currently open wagering market occurring in the retrieved plays. The factor impact module 39728 may identify, at step 40006, a combination of the fewest factors that are closest to the actual odds. For example, the odds of Aaron Judge getting a walk when there is one out and a runner on second might be 8% higher at 18% than his overall walk rate of 10%. If the discrepancy between the expected odds of Aaron Judge getting a hit in the current context (20%) and the odds of him getting a hit in a randomly selected at-bat (30%), then the 8% increase in the probability of a walk may represent 80% of the 10% discrepancy of the odds on a hit. This calculation may assume that the increased odds for a walk came entirely from a decline in hits. Suppose the 8% increase in the probability of a walk came half fewer expected hits and a half from fewer expected outs. This calculation may be consistent with the increased likelihood that a pitcher will pitch around or intentionally walk a batter to set up a double play when there is a runner on second with less than two outs and first base is open. In that case, at least one additional factor may be necessary to account for at least 80% of the discrepancy. It should be noted that 80% is the threshold chosen for an example of a threshold that would indicate the preponderance of the odds discrepancy due to the identified factors. That threshold could be higher or lower depending upon the capacity of the system. An algorithm may dynamically determine it. The factors may continue to be combined until the combination with the fewest factors that can account for at least 80% of the odds discrepancy can be identified. It should be obvious that it may not be possible to calculate odds for all possible combinations in the time when a wagering market is open. A maximum number of possible factors to combine, total attempts, etc., may be used as a cutoff to ensure information is delivered in a timely fashion. Once at least one factor has been identified as potentially responsible for at least 80% of the discrepancy between the expected odds of an outcome and the observed odds of an outcome, the factor impact module 39728 may send, at step 40008, the identified factor, or combination of factors, to the odds factor module 39724.

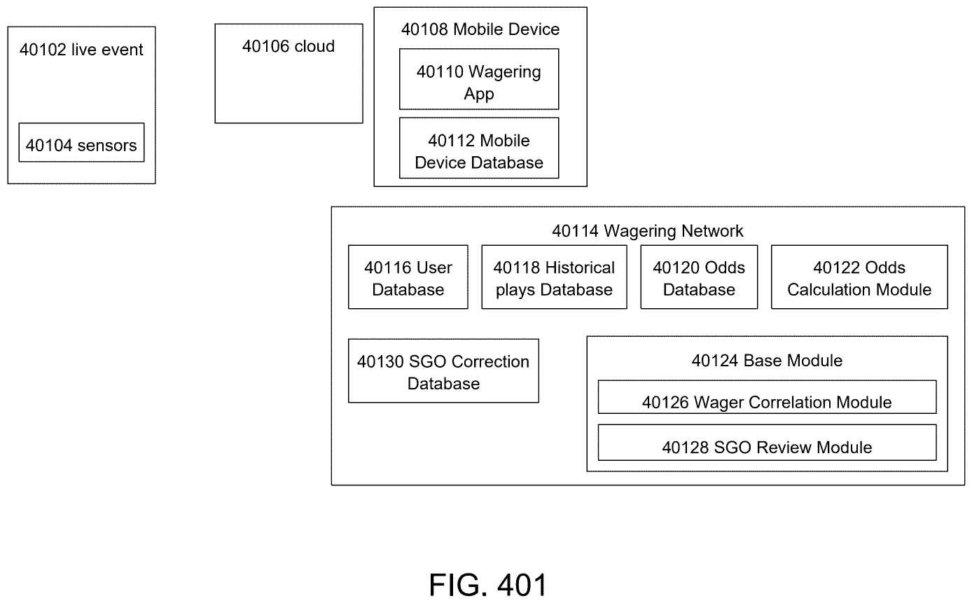

FIG. 401 illustrates a system for managing wager micro-markets with artificial intelligence using human traders, according to an embodiment.

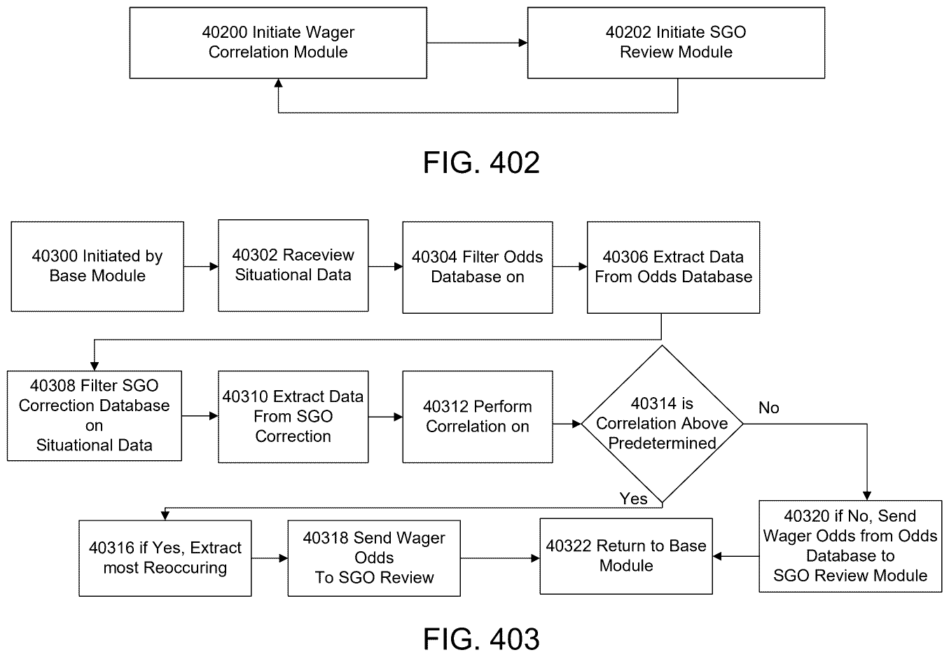

FIG. 402 illustrates a base module, according to an embodiment.

FIG. 403 illustrates a wager correlation module, according to an embodiment.

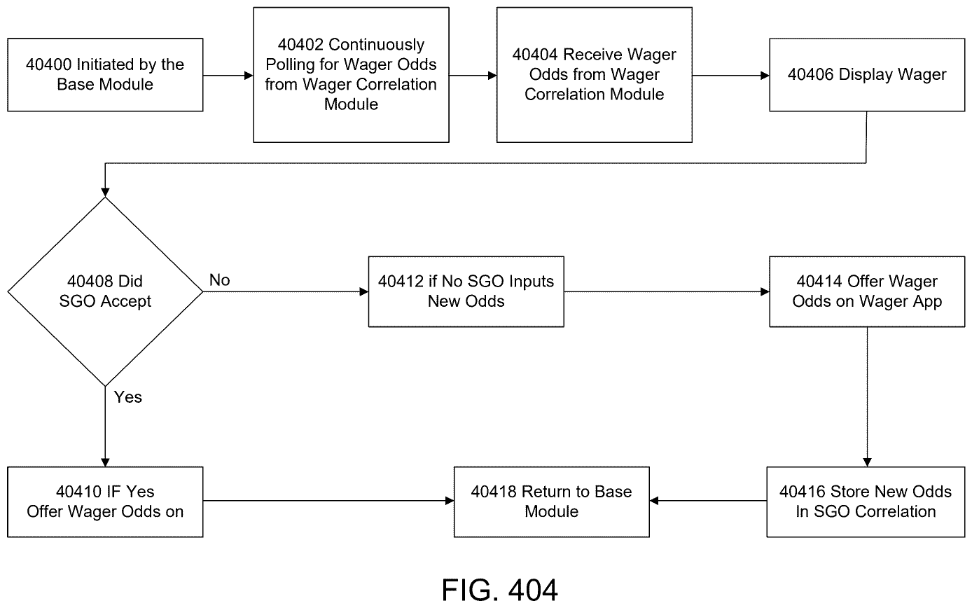

FIG. 404 illustrates an SGO review module, according to an embodiment.

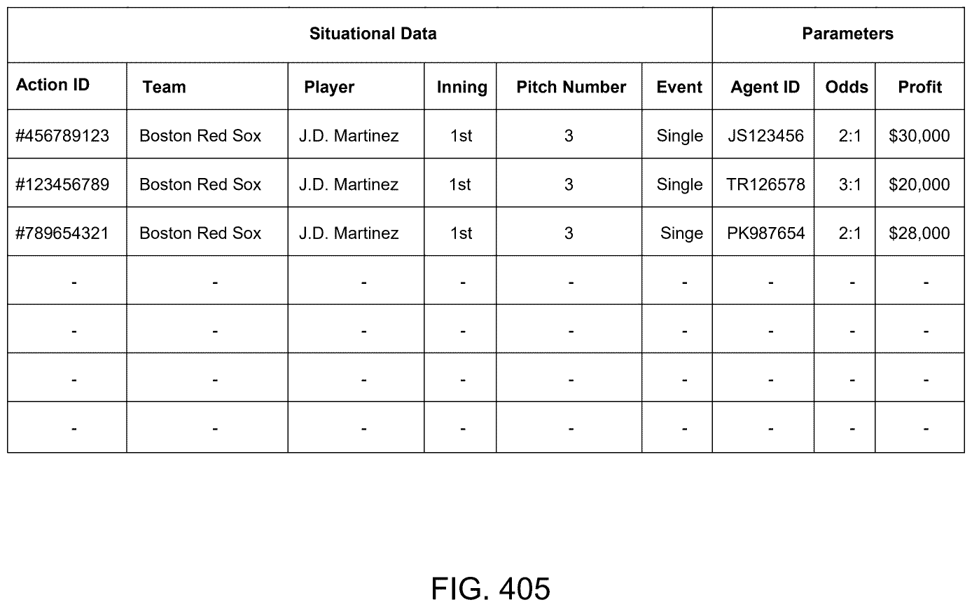

FIG. 405 illustrates an SGO correction database, according to an embodiment.

FIG. 401 is a system for managing wager micro-markets with artificial intelligence using human traders. This system may include a live event 40102, for example, a sporting event such as a football, basketball, baseball, or hockey game, tennis match, golf tournament, eSports or digital game, etc. The live event 40102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 40102, such as the score of an American football game or the run line in a baseball game, or a series of actions in the live event 40102. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 40102 or at another location.

Further, embodiments may include a plurality of sensors 40104 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 40104 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 40106 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 40106 may be communicatively coupled to a peer-to-peer wagering network 40114, which may perform real-time analysis on the type of play and the result of the play. The cloud 40106 may also be synchronized with game situational data such as the time of the game, the score, location on the field, weather conditions, and the like, which may affect the choice of play utilized. For example, in an exemplary embodiment, the cloud 40106 may not receive data gathered from the sensors 40104 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 40108 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 108 could be an optional component and would be utilized in a situation where a paired wearable device employs the mobile device 108 for additional memory or computing power or connection to the internet.

Further, embodiments may include a wagering software application or a wagering app 40110, which is a program that enables the user to place bets on individual plays in the live event 40102, streams audio and video from the live event 40102, and features the available wagers from the live event 40102 on the mobile device 40108. The wagering app 40110 allows the user to interact with the wagering network 40114 to place bets and provide payment/receive funds based on wager outcomes.

Further, embodiments may include a mobile device database 40112 that may store some or all the user's data, the live event 40102, or the user's interaction with the wagering network 40114.

Further, embodiments may include the wagering network 40114, which may perform real-time analysis on the type of play and the result of a play or action. The wagering network 40114 (or the cloud 40106) may also be synchronized with game situational data, such as the time of the game, the score, location on the field, weather conditions, and the like, which may affect the choice of play utilized. For example, in an exemplary embodiment, the wagering network 40114 may not receive data gathered from the sensors 40104 and may, instead, receive data from an alternative data feed, such as SportsRadar®. This data may be provided substantially immediately following the completion of any play, and may be compared with a variety of team data and league data based on a variety of elements, including the current down, possession, score, time, team, and so forth, as described in various exemplary embodiments herein. The wagering network 40114 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 40116, which may contain data relevant to all users of the wagering network 40114 and may include, but is not limited to, a user ID, a device identifier, a paired device identifier, wagering history, or wallet information for the user. The user database 40116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 40116 may contain betting lines and search queries. The user database 40116 may be searched based on a search criterion received from the user. Each betting line may include, but is not limited to, a plurality of betting attributes such as at least one of the live event 40102, a team, a player, an amount of wager, etc. The user database 40116 may include, but is not limited to, information related to all the users involved in the live event 40102. In one exemplary embodiment, the user database 40116 may include information for generating a user authenticity report and a wagering verification report. Further, the user database 40116 may be used to store user statistics like, but not limited to, the retention period for a particular user, frequency of wagers placed by a particular user, the average amount of wager placed by each user, etc.

Further, embodiments may include a historical plays database 40118 that may contain play data for the type of sport being played in the live event 40102. For example, in American Football, for optimal odds calculation, the historical play data may include metadata about the historical plays, such as time, location, weather, previous plays, opponent, physiological data, etc.

Further, embodiments may utilize an odds database 40120—that contains the odds calculated by an odds calculation module 40122—to display the odds on the user's mobile device 40108 and take bets from the user through the mobile device wagering app 40110.

Further, embodiments may include the odds calculation module 40122, which utilizes historical play data to calculate odds for in-play wagers.

Further, embodiments may include a base module 40124, which initiates the wager correlation module 40126, which performs correlations on the data stored in the odds database 40120 and a SGO correction database 40130. A SGO or “Skilled Game Operator” reviews, accepts, or adjusts, and then offers the wager odds available on the wagering app 40110. If the parameters, which are the wager odds vs. the profits, are above a predetermined threshold, those odds are sent to a SGO review module 40128, to the SGO who reviews, accepts, or adjusts, and then offers the wager odds available on the wagering app 40110. if the correlation coefficient is below a predetermined threshold then the wager odds sent to the SGO review module 40128 is from the data stored in the odds database 40120, and in some embodiments may be the odds created from the odds calculation module 40122. Then the base module 40124 initiates the SGO review module 40128, which allows the SGO who reviews, accepts, or adjusts, and then offers the wager odds available on the wagering app 40110, to receive, review and either accept or change the wagering odds that are presented on the wagering app 40110. If the data is altered, such as an input of wager odds from the SGO, the data is stored in the SGO correction database 40130.

Further, embodiments may include a wager correlation module 40126 that receives the situational data of the live event 40102. For example, the received situational data may be the Boston Red Sox J. D. Martinez is up to bat in the first inning, and it will be the third pitch of the at-bat. In some embodiments, the situational data received may be information related to the current state of the live event 40102, such as the time within the live event 40102, the teams involved, the players involved, etc. The wager correlation module 40126 may filter the odds database 40120 on the received situational data. For example, the odds database 40120 may be filtered for the Boston Red Sox J. D. Martinez being up to bat in the first inning, where it will be the third pitch of the at-bat and the event being J. D. Martinez hitting a single. The remaining data is the historical wager odds for the previous situations in which J. D. Martinez hit a single on the third pitch of the at-bat. Then the wager correlation module 40126 may extract the data from the odds database 40120. For example, the extracted data may be the historical wager odds and profits from the historical instances in which J. D. Martinez hit a single on the third pitch of the at-bat. The wager correlation module 40126 may filter the SGO correction database 40130 on the received situational data. For example, the SGO correction database 40130 may be filtered for the Boston Red Sox J. D. Martinez being up to bat in the first inning, where it will be the third pitch of the at-bat, and where the event being J. D. Martinez hitting a single so that the remaining data are the historical wager odds for the previous situations in which J. D. Martinez hit a single on the third pitch of the at-bat. Then the wager correlation module 40126 may extract the data from the SGO correction database 40130. For example, the extracted data is the historical wager odds and profits in which an SGO inputted their own wager odds for J. D. Martinez to hit a single on the third pitch of the at-bat. The wager correlation module 40126 may perform correlations on the extracted data from the odds database 40120 and the SGO correction database 40130. For example, the extracted data is for J. D. Martinez to hit a single in the first inning on the third pitch of the at-bat, and then correlations are performed on the wager odds and profits for those wager odds in that situation. An example of correlated parameters is the wager odds vs. profits may have a 0.97 correlation coefficient, and the most reoccurring data point may be extracted. For example, the wager odds being 2:1 with a profit of $20,000 and these wager odds, such as 2:1, are sent to the SGO review module 40128 for the SGO to either accept or input their wager odds for the situation. Another example may be if the situational data is the Boston Red Sox J. D. Martinez is up to bat in the first inning, and it will be the third pitch of the at-bat and the event being J. D. Martinez hitting a home run. Another example of correlated data may be the wager odds vs. profits, which may have a correlation coefficient of 0.95, and the most reoccurring data point is extracted. For example, the wager odds may be 6:1 with a profit of $35,000, and these wager odds, may be sent to the SGO review module 40128 for the SGO to either accept or input their own wager odds for the situation. An example of uncorrelated data may be the situational data where the Boston Red Sox J. D. Martinez is up to bat in the first inning. It will be the third pitch of the at-bat and the event is a base is stolen by a runner at first, and the correlated parameters of the wager are odds vs. profits with a 0.54 correlation coefficient which would result in the correlation coefficient not being above a predetermined threshold. The wager odds from the odds database 40120, or in some embodiments the odds from the odds calculation module 40122, may then be sent to the SGO review module 40128. The wager correlation module 40126 may determine if the correlation is above a predetermined threshold, for example, above a 0.75 correlation coefficient. For example, the predetermined threshold may be a correlation coefficient of 0.90, and if the correlations performed on the wager odds vs. profits with the same situational data, then the most reoccurring data point is extracted. The wager odds from the data point may be sent to the SGO review module 40128. If the correlation coefficient is below the 0.90 correlation coefficient, then the SGO review module 40128 may receive the wager odds from the odds database 40120, or in some embodiments, receive odds from the odds calculation module 40122. If it is determined that the correlation coefficient is above the predetermined threshold, then the wager correlation module 40126 may extract the most reoccurring data point. For example, the predetermined threshold may be a correlation coefficient of 0.90, and if the correlations are performed on the wager odds vs. profits with the same situational data, then the most reoccurring data point is extracted, then the wager odds from the data point may be sent to the SGO review module 40128. Then the wager correlation module 40126 may send the wager odds to the SGO review module 40128. For example, the wager odds that are sent are there are odds at 2:1 that Boston Red Sox J. D. Martinez is up to bat in the first inning, and it will be the third pitch of the at-bat and the event being a single. If it is determined that the correlation coefficient is below the predetermined threshold, then the wager correlation module 40126 may send the wager odds from the odds database 40120 to the SGO review module 40128. In some embodiments, the wager odds may be the wager odds calculated in the odds calculation module 40122. Then the wager correlation module 40126 returns to the base module 40124.

Further, embodiments may include an SGO review module 40128, which may continuously poll for wager odds from the wager correlation module 40126. For example, the SGO review module 40128 may receive the wager odds for the SGO to review. Then the SGO review module 40128 receives the wager odds from the wager correlation module 40126. For example, the wager odds for Boston Red Sox J. D. Martinez hitting a single in the first inning on the third pitch is 2:1. The SGO review module 40128 displays the wager odds to the SGO. For example, the wager odds of 2:1 for Boston Red Sox J. D. Martinez to hit a single in the first inning on the third pitch are displayed to the SGO. Then it is determined if the SGO accepts the wager odds. For example, the SGO may accept the 2:1 wager odds, or the SGO may disagree with the presented wager odds and input their wager odds. If it is determined that the SGO accepted the wager odds, then the wager odds are offered on the wagering app 40110. If it is determined that the SGO did not accept the wager odds, then the SGO inputs the new wager odds. For example, the SGO may adjust the wager odds from 2:1 to 3:1. Then the SGO review module 40128 offers the inputted wager odds on the wagering app 40110. The SGO review module 40128 stores the new odds in the SGO correction database 40130. For example, the SGO correction database 40130 stores the situational data, such as the team is the Boston Red Sox, the player being J. D. Martinez, the inning being the 1st, the pitch is the 3rd, the event being to hit a single, and the wager odds being 3:1. The SGO review module 40128 returns to the base module 40124.

Further, embodiments may include an SGO correction database 40130, which is created from the process described in the SGO review module 40128 in which when an SGO inputs new wager odds for a wager the situational data from the event and the wager as well as profits from that wager are stored in the SGO correction database 40130. The database contains the situational data, such as the action I.D., the team, the player, the inning, or the time of the event, the pitch number, and the event, as well the parameters such as the agent ID, the wager odds, and the profit amount.

FIG. 402 illustrates the base module 40124. The process begins with the base module 40124 initiating, at step 40200, the wager correlation module 40126. For example, the wager correlation module 40126 receives the situational data from the live event 40102. For example, the received situational data may be the Boston Red Sox J. D. Martinez is up to bat in the first inning, and it will be the third pitch of the at-bat. In some embodiments, the situational data received may be information related to the current state of the live event 40102, such as the time within the live event 40102, the teams involved, the players involved, etc. The wager correlation module 40126 filters the odds database 40120 on the received situational data. For example, the odds database 40120 is filtered for the Boston Red Sox J. D. Martinez is up to bat in the first inning, and it will be the third pitch of the at-bat and the event being J. D. Martinez hitting a single so that the remaining data are the historical wager odds for the previous situations in which J. D. Martinez hit a single on the third pitch of the at-bat. Then the wager correlation module 40126 extracts the data from the odds database 40120. For example, the extracted data is the historical wager odds and profits from the historical instances in which J. D. Martinez hit a single on the third pitch of the at-bat. The wager correlation module 40126 filters the SGO correction database 40130 on the received situational data. For example, the SGO correction database 40130 is filtered for the Boston Red Sox J. D. Martinez is up to bat in the first inning, and it will be the third pitch of the at-bat and the event being J. D. Martinez hitting a single so that the remaining data are the historical wager odds for the previous situations in which J. D. Martinez hit a single on the third pitch of the at-bat. Then the wager correlation module 40126 extracts the data from the SGO correction database 40130. For example, the extracted data is the historical wager odds and profits in which an SGO inputted their own wager odds for J. D. Martinez to hit a single on the third pitch of the at-bat. The wager correlation module 40126 performs correlations on the extracted data from the odds database 40120 and the SGO correction database 40130. For example, the extracted data is for J. D. Martinez to hit a single in the first inning on the third pitch of the at-bat, and then correlations are performed on the wager odds and profits for those wager odds in that situation. An example of correlated parameters is with the wager odds vs. profits with a 0.97 correlation coefficient, and the most reoccurring data point is extracted, for example, the wager odds being 2:1 with a profit of $20,000 and these wager odds, such as 2:1, are sent to the SGO review module 40128 for the SGO to either accept or input their own wager odds for the situation. Another example may be if the situational data is the Boston Red Sox J. D. Martinez is up to bat in the first inning, and it will be the third pitch of the at-bat and the event being a home run. An example of the correlated data is with the wager odds vs. profits with a correlation coefficient of 0.95, and the most reoccurring data point is extracted, for example, the wager odds being 6:1 with a profit of $35,000 and these wager odds, such as 6:1, are sent to the SGO review module 40128 for the SGO to either accept or input their own wager odds for the situation. An example of uncorrelated data would be if the situational data were the Boston Red Sox J. D. Martinez is up to bat in the first inning. It will be the third pitch of the at-bat and the event being a stolen base by a runner a first and the correlated parameters of the wager odds vs. profits with a 0.54 correlation coefficient which would result in the correlation coefficient not being above a predetermined threshold and the wager odds from the odds database 40120, or in some embodiments the odds from the odds calculation module 40122, would be sent to the SGO review module 40128. The wager correlation module 40126 determines if the correlation is above a predetermined threshold, for example, above a 0.75 correlation coefficient. For example, the predetermined threshold may be a correlation coefficient of 0.90, and if the correlations performed on the wager odds vs. profits with the same situational data, then the most reoccurring data point is extracted. The wager odds from the data point are sent to the SGO review module 40128. If the correlation coefficient is below the 0.90 correlation coefficient, then the SGO review module 40128 will receive the wager odds from the odds database 40120, or in some embodiments, receive odds from the odds calculation module 40122. If it is determined that the correlation coefficient is above the predetermined threshold, then the wager correlation module 40126 extracts the most reoccurring data point. For example, the predetermined threshold may be a correlation coefficient of 0.90, and if the correlations performed on the wager odds vs. profits with the same situational data, then the most reoccurring data point is extracted, and the wager odds from the data point are sent to the SGO review module 40128. Then the wager correlation module 40126 sends the wager odds to the SGO review module 40128. For example, the wager odds that are sent are there are odds at 2:1 that Boston Red Sox J. D. Martinez is up to bat in the first inning, and it will be the third pitch of the at-bat and the event being a single. If it is determined that the correlation coefficient is below the predetermined threshold, then the wager correlation module 40126 sends the wager odds from the odds database 40120 to the SGO review module 40128. In some embodiments, the wager odds may the wager odds calculated in the odds calculation module 40122. Then the wager correlation module 40126 returns to the base module 40124. Then the base module 40124 initiates, at step 40202, the SGO review module 40128. For example, the SGO review module 40128 may continuously poll for wager odds from the wager correlation module 40126. For example, the SGO review module 40128 will receive the wager odds for the SGO to review. Then the SGO review module 40128 receives the wager odds from the wager correlation module 40126. For example, the wager odds for Boston Red Sox J. D. Martinez hitting a single in the first inning on the third pitch is 2:1. The SGO review module 40128 displays the wager odds to the SGO. For example, the wager odds of 2:1 for Boston Red Sox J. D. Martinez to hit a single in the first inning on the third pitch are displayed to the SGO. Then it is determined if the SGO accepted the wager odds. For example, the SGO may accept the 2:1 wager odds, or the SGO may disagree with the presented wager odds and input their wager odds. If it is determined that the SGO accepted the wager odds, then the wager odds are offered on the wagering app 40110. If it is determined that the SGO did not accept the wager odds, then the SGO inputs the new wager odds. For example, the SGO may adjust the wager odds from 2:1 to 3:1. Then the SGO review module 40128 offers the inputted wager odds on the wagering app 40110. The SGO review module 40128 stores the new odds in the SGO correction database 40130. For example, the SGO correction database 40130 stores the situational data, such as the team is the Boston Red Sox, the player being J. D. Martinez, the inning being the 1st, the pitch is the 3rd, the event being to hit a single, and the wager odds being 3:1. The SGO review module 40128 returns to the base module 40124.

FIG. 403 illustrates the wager correlation module 40126. The process begins with the wager correlation module 40126 being initiated, at step 40300, by the base module 40124. Then the wager correlation module 40126 receives, at step 40302, the situational data from the live event 40102. For example, the received situational data may be the Boston Red Sox J. D. Martinez is up to bat in the first inning, and it will be the third pitch of the at-bat. In some embodiments, the situational data received is information related to the current state of the live event 40102, such as the time within the live event 40102, the teams involved, the players involved, etc. The wager correlation module 40126 filters, at step 40304, the odds database 40120 on the received situational data. For example, the odds database 40120 is filtered for the Boston Red Sox J. D. Martinez is up to bat in the first inning, and it will be the third pitch of the at-bat and where the event is J. D. Martinez hitting a single. The remaining data is the historical wager odds for the previous situations in which J. D. Martinez hit a single on the third pitch of the at-bat. Then the wager correlation module 40126 extracts, at step 40306, the data from the odds database 40120. For example, the extracted data is the historical wager odds and profits from the historical instances in which J. D. Martinez hit a single on the third pitch of the at-bat. The wager correlation module 40126 filters, at step 40308, the SGO correction database 40130 on the received situational data. For example, the SGO correction database 40130 is filtered for the Boston Red Sox J. D. Martinez is up to bat in the first inning, and it will be the third pitch of the at-bat, where the event is J. D. Martinez hitting a single. The remaining data is the historical wager odds for the previous situations in which J. D. Martinez hit a single on the third pitch of the at-bat. Then the wager correlation module 40126 extracts, at step 40310, the data from the SGO correction database 40130. For example, the extracted data is the historical wager odds and profits in which an SGO inputted their own wager odds for J. D. Martinez to hit a single on the third pitch of the at-bat. The wager correlation module 40126 performs, at step 40312, correlations on the extracted data from the odds database 40120 and the SGO correction database 40130. For example, the extracted data is for J. D. Martinez to hit a single in the first inning on the third pitch of the at-bat, and then correlations are performed on the wager odds and profits for those wager odds in that situation. An example of correlated parameters is where the wager odds vs. profits have a 0.97 correlation coefficient, and the most reoccurring data point is extracted, for example, the wager odds being 2:1 with a profit of $20,000 and these wager odds, such as 2:1, are sent to the SGO review module 40128 for the SGO to either accept or input their own wager odds for the situation. Another example may be if the situational data is the Boston Red Sox J. D. Martinez is up to bat in the first inning, and it will be the third pitch of the at-bat and the event being a home run. An example of the correlated data is with the wager odds vs. profits with a correlation coefficient of 0.95, and the most reoccurring data point is extracted, for example, the wager odds being 6:1 with a profit of $35,000 and these wager odds, such as 6:1, are sent to the SGO review module 40128 for the SGO to either accept or input their own wager odds for the situation. An example of uncorrelated data would be in if the situational data was the Boston Red Sox J. D. Martinez is up to bat in the first inning and it will be the third pitch of the at-bat and the event being a stolen base by a runner a first and the correlated parameters of the wager odds vs. profits with a 0.54 correlation coefficient which would result in the correlation coefficient not being a above a predetermined threshold and the wager odds from the odds database 40120, or in some embodiments the odds from the odds calculation module 40122, would be sent to the SGO review module 40128. The wager correlation module 40126 determines, at step 40314, if the correlation is above a predetermined threshold, for example, above a 0.75 correlation coefficient. For example, the predetermined threshold may be a correlation coefficient of 0.90, and if the correlations performed on the wager odds vs. profits with the same situational data, then the most reoccurring data point is extracted. The wager odds from the data point are sent to the SGO review module 40128. If the correlation coefficient is below the 0.90 correlation coefficient, then the SGO review module 40128 will receive the wager odds from the odds database 40120, or in some embodiments, receive odds from the odds calculation module 40122. If it is determined that the correlation coefficient is above the predetermined threshold, then the wager correlation module 40126 extracts, at step 40316, the most reoccurring data point. For example, the predetermined threshold may be a correlation coefficient of 0.90, and if the correlations performed on the wager odds vs. profits with the same situational data, then the most reoccurring data point is extracted, and the wager odds from the data point are sent to the SGO review module 40128. Then the wager correlation module 40126 sends, at step 40318, the wager odds to the SGO review module 40128. For example, the wager odds that are sent are there are odds at 2:1 that Boston Red Sox J. D. Martinez is up to bat in the first inning, and it will be the third pitch of the at-bat and the event being J. D. Martinez hitting a single. If it is determined that the correlation coefficient is below the predetermined threshold, then the wager correlation module 40126 sends, at step 40320, the wager odds from the odds database 40120 to the SGO review module 40128. In some embodiments, the wager odds may the wager odds calculated in the odds calculation module 40122. Then the wager correlation module 40126 returns, at step 40322, to the base module 40124.

FIG. 404 illustrates the SGO review module 40128. The process begins with the SGO review module 40128 being initiated, at step 40400, by the base module 40124. The SGO review module 40128 continuously poll, at step 40402, for wager odds from the wager correlation module 40126. For example, the SGO review module 40128 will receive the wager odds for the SGO to review. Then the SGO review module 40128 receives, at step 40404, the wager odds from the wager correlation module 40126. For example, the wager odds for Boston Red Sox J. D. Martinez hitting a single in the first inning on the third pitch is 2:1. The SGO review module 40128 displays, at step 40406, the wager odds to the SGO. For example, the wager odds of 2:1 for Boston Red Sox J. D. Martinez to hit a single in the first inning on the third pitch are displayed to the SGO. Then it is determined, at step 40408, if the SGO accepted the wager odds. For example, the SGO may accept the 2:1 wager odds, or the SGO may disagree with the presented wager odds and input their wager odds. If it is determined that the SGO accepted the wager odds, then the wager odds are offered, at step 40410, on the wagering app 40110. If it is determined that the SGO did not accept the wager odds, then the SGO inputs, at step 40412, the new wager odds. For example, the SGO may adjust the wager odds from 2:1 to 3:1. Then the SGO review module 40128 offers, at step 40414, the inputted wager odds on the wagering app 40110. The SGO review module 40128 stores, at step 40416, the new odds in the SGO correction database 40130. For example, the SGO correction database 40130 stores the situational data, such as the team being the Boston Red Sox, the player being J. D. Martinez, the inning being the 1st, the pitch is the 3rd, the event being to hit a single, and the wager odds being 3:1. The SGO review module 40128 returns, at step 40418, to the base module 40124.

FIG. 405 illustrates the SGO correction database 40130. The database is created from the process described in the SGO review module 40128, in which when an SGO inputs new wager odds for a wager, the situational data from the event and the wager as well as profits from that wager are stored in the SGO correction database 40130. The database contains the situational data, such as the action I.D., the team, the player, the inning, or the time of the event, the pitch number, and the event, as well the parameters such as the agent ID, the wager odds, and the profit amount.

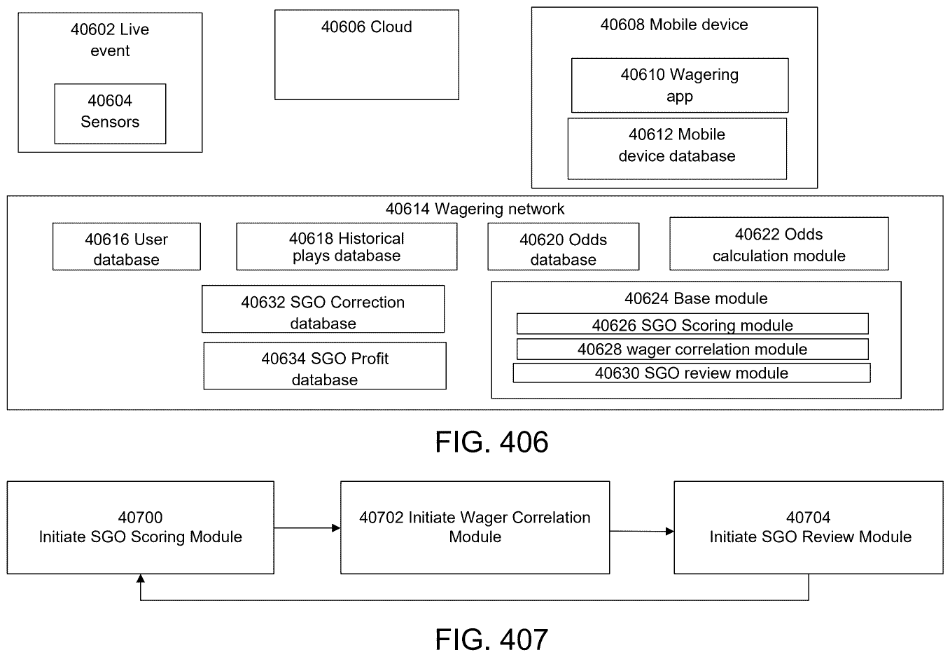

FIG. 406 illustrates a system for managing wager micro-markets with AI using human traders and weighted datasets, according to an embodiment.

FIG. 407 illustrates a base module, according to an embodiment.

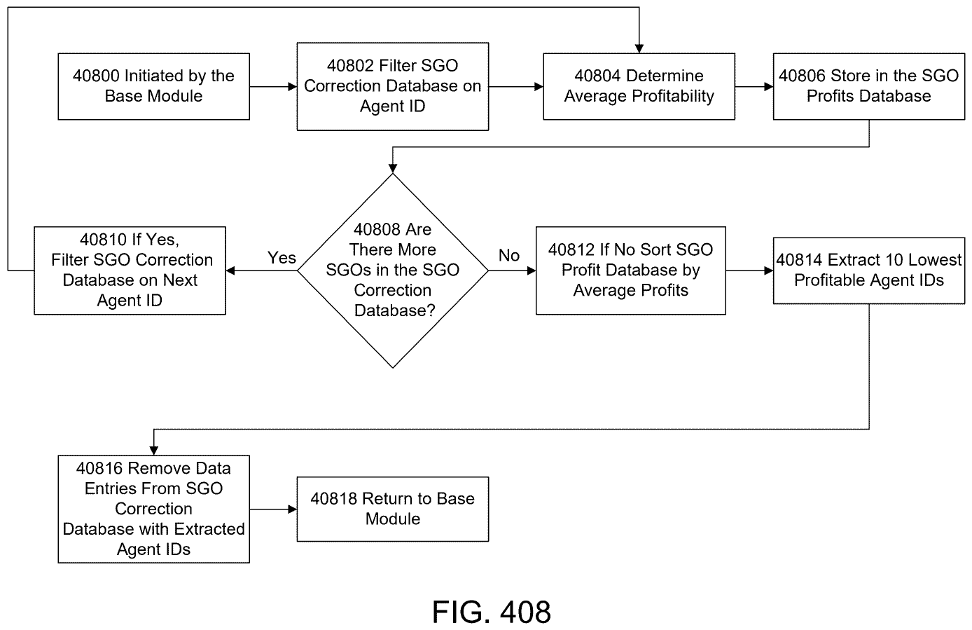

FIG. 408 illustrates an SGO scoring module, according to an embodiment.

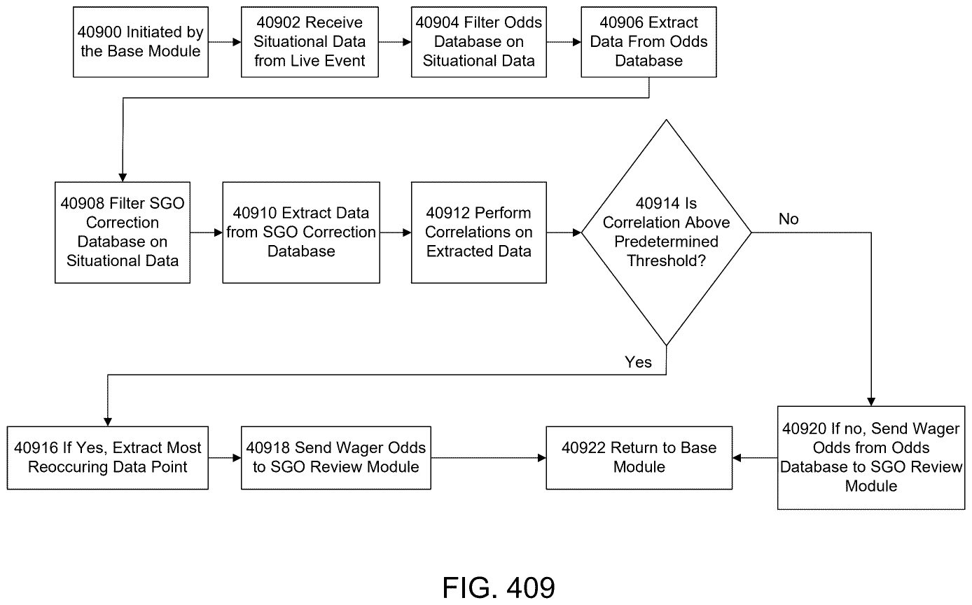

FIG. 409 illustrates a wager correlation module, according to an embodiment.

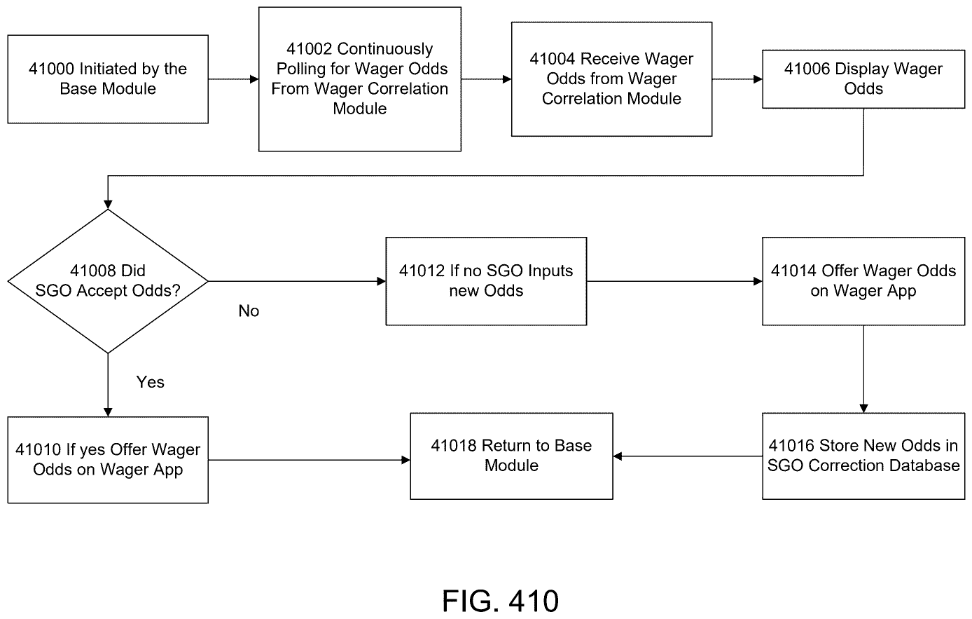

FIG. 410 illustrates an SGO review module, according to an embodiment.

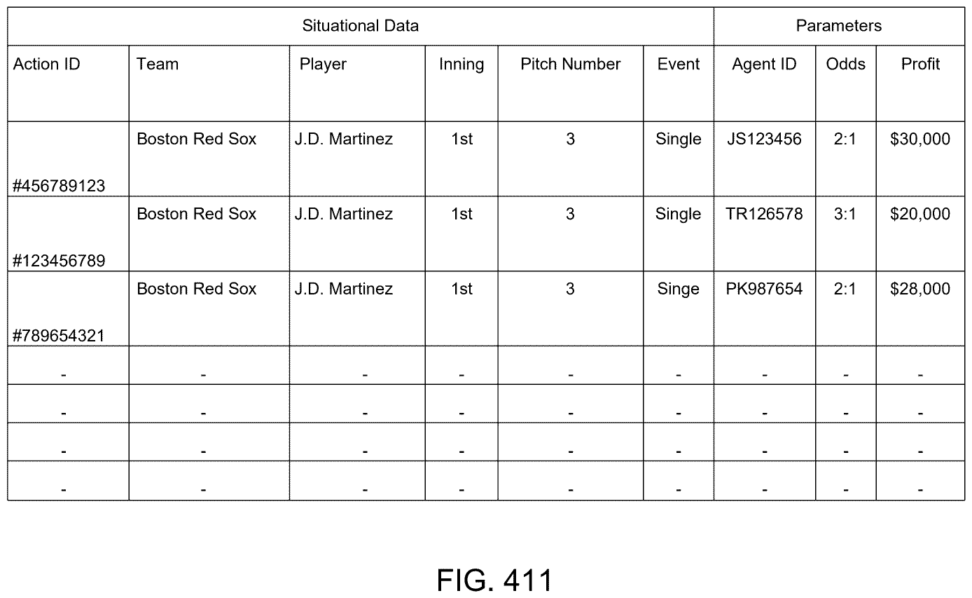

FIG. 411 illustrates an SGO correction database, according to an embodiment.

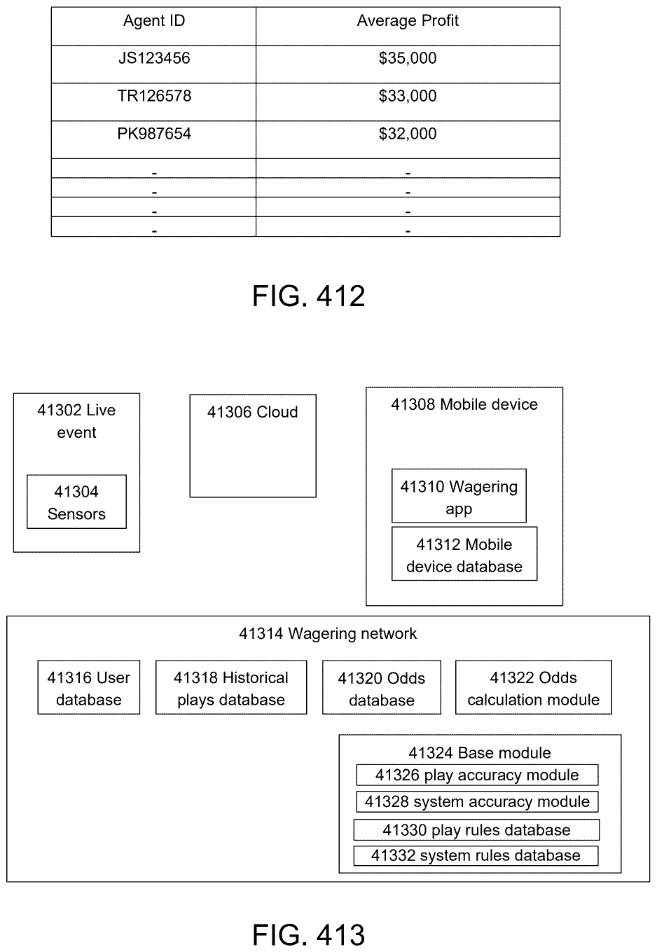

FIG. 412 illustrates an SGO profit database, according to an embodiment.

FIG. 406 is a system for managing wager micro-markets with AI using human traders and weighted datasets. This system may include a live event 40602, for example, a sporting event such as a football, basketball, baseball, or hockey game, tennis match, golf tournament, eSports, or digital game, etc. The live event 40602 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 40602, such as the score of an American football game or the run line in a baseball game, or a series of actions in the live event 40602. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 40602 or at another location.

Further, embodiments may include a plurality of sensors 40604 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 40604 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 40606 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 40606 may be communicatively coupled to a peer-to-peer wagering network 40614, which may perform real-time analysis on the type of play and the result of the play. The cloud 40606 may also be synchronized with game situational data such as the time of the game, the score, location on the field, weather conditions, and the like, which may affect the choice of play utilized. For example, in an exemplary embodiment, the cloud 40606 may not receive data gathered from the sensors 40604 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 40608 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 40608 could be an optional component and would be utilized in a situation where a paired wearable device employs the mobile device 40608 for additional memory or computing power or connection to the internet.

Further, embodiments may include a wagering software application or a wagering app 40610, which is a program that enables the user to place bets on individual plays in the live event 40602, streams audio and video from the live event 40602, and features the available wagers from the live event 40602 on the mobile device 40608. The wagering app 40610 allows the user to interact with the wagering network 40614 to place bets and provide payment/receive funds based on wager outcomes.

Further, embodiments may include a mobile device database 40612 that may store some or all the user's data, the live event 40602, or the user's interaction with the wagering network 40614.

Further, embodiments may include the wagering network 40614, which may perform real-time analysis on the type of play and the result of a play or action. The wagering network 40614 (or the cloud 40606) may also be synchronized with game situational data, such as the time of the game, the score, location on the field, weather conditions, and the like, which may affect the choice of play utilized. For example, in an exemplary embodiment, the wagering network 40614 may not receive data gathered from the sensors 40604 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 40614 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 40616, which may contain data relevant to all users of the wagering network 40614 and may include, but is not limited to, a user ID, a device identifier, a paired device identifier, wagering history, or wallet information for the user. The user database 40616 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 40616 may contain betting lines and search queries. The user database 40616 may be searched based on a search criterion received from the user. Each betting line may include but is not limited to, a plurality of betting attributes such as at least one of the following: the live event 40602, a team, a player, an amount of wager, etc. The user database 40616 may include, but is not limited to, information related to all the users involved in the live event 40602. In one exemplary embodiment, the user database 40616 may include information for generating a user authenticity report and a wagering verification report. Further, the user database 40616 may be used to store user statistics like, but not limited to, the retention period for a particular user, frequency of wagers placed by a particular user, the average amount of wager placed by each user, etc.

Further, embodiments may include a historical plays database 40618 that may contain play data for the type of sport being played in the live event 40602. For example, in American Football, for optimal odds calculation, the historical play data may include metadata about the historical plays, such as time, location, weather, previous plays, opponent, physiological data, etc.

Further, embodiments may utilize an odds database 40620—that contains the odds calculated by an odds calculation module 40622—to display the odds on the user's mobile device 40608 and take bets from the user through the mobile device wagering app 40610.

Further, embodiments may include the odds calculation module 40622, which may utilize historical play data to calculate odds for in-play wagers.

Further, embodiments may include a base module 40624 which may initiate the SGO scoring module 40626 that may determine the highest profitable SGOs, or skilled game operators, to provide a more refined dataset in the SGO correction database 40632. A skilled game operator may be a human who sets or defines odds or determines the validity of odds. The base module 40624 may initiate the wager correlation module 40628, which may perform correlations on the data stored in the odds database 40620 and SGO correction database 40632. An SGO may review, accept, adjust, and offer the available wager odds via the wagering app 40610. Suppose the parameters, which are the wager odds vs. the profits, are above a predetermined threshold. In that case, those odds may be sent to the SGO review module 40630. An SGO may review, accept, adjust, and offer the available wager odds via the wagering app 40610. If the correlation coefficient is below a predetermined threshold, then the wager odds sent to the SGO review module 40630 may be from the data stored in the odds database 40620, and in some embodiments may be the odds created from the odds calculation module 40622. The base module 40624 may initiate the SGO review module 40630, which allows the SGO, to receive, review and either accept or change the wagering odds that are presented on the wagering app 40610. If the data is altered, such as an input of wager odds from the SGO, the data may be stored in the SGO correction database 40632.

Further, embodiments may include an SGO scoring module 40626, which may filter the SGO correction database 40632 for the agent ID. For example, the SGO correction database 40632 may be filtered for the Agent ID JS123456 to see all the corrections inputted by that skilled game operator or agent. The SGO scoring module 40626 may determine the average profitability of the agent. For example, the SGO scoring module 40626 may add up all the profits corresponding to the entries with the same agent ID and then divide the total number of profits by the number of entries to determine the agent's average profit when they make an adjustment or correction. The SGO scoring module 40626 may store the average profitability in the SGO profits database 40634. For example, the SGO scoring module 40626 may store the agent ID, such as JS123456, with an average profit of $35,000. Then it is determined if there are more SGOs in the SGO correction database 40632. For example, the SGO scoring module 40626 may determine if any other skilled game operators are present and determine the average profitability of agents. If more agents remain in the SGO correction database 40632, the SGO scoring module 40626 may filter the SGO correction database 40632 for the next agent ID, and the process may return to determining the average profitability for the next agent. If there are no more agents remaining in the SGO correction database 40632, the SGO scoring module 40626 may sort the SGO profit database 40634 by the average profitability. The SGO scoring module 40626 may extract the ten lowest profitable agent IDS. For example, the SGO scoring module 40626 may select the lowest average profitable agents to provide a weighted score for the process described in the wager correlation module 40628, so only the best performing skilled game operators or agent's odds are used in the correlations. In some embodiments, there may be another number selected to remove the lowest profitable agents such as 5, 15, 20, etc. In some embodiments, the agents remaining may need to reach a certain profitability threshold to be selected, such as average profitability over a predetermined threshold such as $30,000 per wager adjustment. The SGO scoring module 40626 may remove the data entries with extracted agent IDs. For example, any agent determined to be the lowest profitable agent may have their data entries removed from the SGO correction database 40632 so that they are not used in the process described in the wager correlation module 40628 thus possibly providing a more refined dataset for the correlations. The SGO scoring module 40626 may return to the base module 40624.

Further, embodiments may include a wager correlation module 40628 that may receive the live event 40602 situational data. For example, the received situational data may be the Boston Red Sox J. D. Martinez up to bat in the first inning, and with the third pitch of the at-bat. In some embodiments, the situational data received may be information related to the current state of the live event 40602, such as the time within the live event 40602, the teams involved, the players involved, etc. The wager correlation module 40628 may filter the odds database 40620 for the received situational data. For example, the odds database 40620 may be filtered having the Boston Red Sox J. D. Martinez up to bat in the first inning, and with the third pitch of the at-bat and the event being J. D. Martinez hitting a single so that the remaining data are the historical wager odds for the previous situations in which J. D. Martinez hit a single on the third pitch of the at-bat. The wager correlation module 40628 may extract the data from the odds database 40620. For example, the extracted data may be the historical wager odds and profits from the historical instances in which J. D. Martinez hit a single on the third pitch of the at-bat. The wager correlation module 40628 may filter the SGO correction database 40632 for the received situational data. For example, the SGO correction database 40632 may be filtered for the Boston Red Sox J. D. Martinez up to bat in the first inning, and with the third pitch of the at-bat and the event being J. D. Martinez hitting a single so that the remaining data are the historical wager odds for the previous situations in which J. D. Martinez hit a single on the third pitch of the at-bat. The wager correlation module 40628 may extract the data from the SGO correction database 40632. For example, the extracted data may be the historical wager odds and profits in which an SGO inputted their own wager odds for J. D. Martinez to hit a single on the third pitch of the at-bat. The wager correlation module 40628 may perform correlations on the extracted data from the odds database 40620 and the SGO correction database 40632. For example, the extracted data may be for J. D. Martinez to hit a single in the first inning on the third pitch of the at-bat, and then correlations may be performed on the wager odds and profits for those wager odds in that situation. An example of correlated parameters may be with the wager odds vs. profits with a 0.97 correlation coefficient, and the most reoccurring data point may be extracted, for example, the wager odds being 2:1 with a profit of $20,000 and these wager odds, such as 2:1, may be sent to the SGO review module 40630 for the SGO to either accept or input their own wager odds for the situation. Another example may be if the situational data has the Boston Red Sox J. D. Martinez up to bat in the first inning, and with the third pitch of the at-bat and the event being a home run. An example of the correlated data may be with the wager odds vs. profits with a correlation coefficient of 0.95, and the most reoccurring data point may be extracted, for example, the wager odds being 6:1 with a profit of $35,000 and these wager odds, such as 6:1, may be sent to the SGO review module 40630 for the SGO to either accept or input their own wager odds for the situation. An example of uncorrelated data may be if the situational data was the Boston Red Sox J. D. Martinez up to bat in the first inning, with the third pitch of the at-bat of the event being a stolen base by a runner and the correlated parameters of the wager odds vs. profits with a 0.54 correlation coefficient. This may result in the correlation coefficient not being a above a predetermined threshold and the wager odds from the odds database 40620, or in some embodiments the odds from the odds calculation module 40622, may be sent to the SGO review module 40630. The wager correlation module 40628 may determine if the correlation is above a predetermined threshold, for example, above a 0.75 correlation coefficient. For example, the predetermined threshold may be a correlation coefficient of 0.90, and if the correlations are performed on the wager odds vs. profits with the same situational data, then the most reoccurring data point may be extracted. The wager odds from the data point may be sent to the SGO review module 40630. If the correlation coefficient is below the 0.90 correlation coefficient, then the SGO review module 40630 may receive the wager odds from the odds database 40620, or in some embodiments, receive odds from the odds calculation module 40622. If the correlation coefficient is above the predetermined threshold, then the wager correlation module 40628 may extract the most reoccurring data point. For example, the predetermined threshold may be a correlation coefficient of 0.90, and if the correlations are performed on the wager odds vs. profits with the same situational data, then the most reoccurring data point may be extracted, and the wager odds from the data point may be sent to the SGO review module 40630. The wager correlation module 40628 may send the wager odds to the SGO review module 40630. For example, the wager odds that may be sent may be odds at 2:1 that Boston Red Sox J. D. Martinez is up to bat in the first inning, with the third pitch of the at-bat and the event being a single. If the correlation coefficient is below the predetermined threshold, then the wager correlation module 40628 may send the wager odds from the odds database 40620 to the SGO review module 40630. In some embodiments, the wager odds sent may be the wager odds calculated in the odds calculation module 40622. The wager correlation module 40628 may return to the base module 40624.

Further, embodiments may include an SGO review module 40630, which may continuously poll for wager odds from the wager correlation module 40628. For example, the SGO review module 40630 may receive the wager odds for the SGO to review. The SGO review module 40630 may receive the wager odds from the wager correlation module 40628. For example, the wager odds for Boston Red Sox J. D. Martinez hitting a single in the first inning on the third pitch may be 2:1. The SGO review module 40630 may display the wager odds to the SGO. For example, the wager odds of 2:1 for Boston Red Sox J. D. Martinez to hit a single in the first inning on the third pitch may be displayed to the SGO. The SGO review module 40630 may determine if the SGO accepted the wager odds. For example, the SGO may accept the 2:1 wager odds, or the SGO may disagree with the presented wager odds and input their wager odds. If the SGO accepted the wager odds, then the wager odds may be offered on the wagering app 40610. If the SGO did not accept the wager odds, then the SGO may input the new wager odds. For example, the SGO may adjust the wager odds from 2:1 to 3:1. The SGO review module 40630 may offer the inputted wager odds on the wagering app 40610. The SGO review module 40630 may store the new odds in the SGO correction database 40632. For example, the SGO correction database 40632 may store the situational data such as the team being the Boston Red Sox, the player being J. D. Martinez, the inning being the 1st, the pitch being the 3rd, the event is to hit a single, and the wager odds being 3:1. The SGO review module 40630 may return to the base module 40624.

Further, embodiments may include an SGO correction database 40632, which may be created from the process described in the SGO review module 40630 in which when an SGO may input new wager odds for a wager the situational data from the event and the wager as well as profits from that wager are stored in the SGO correction database 40632. The SGO correction database 40632 may contain the situational data, such as the action ID, the team, the player, the inning, or the time of the event, the pitch number, and the event, as well the parameters such as the agent ID, the wager odds, and the profit amount.

Further, embodiments may include an SGO profit database 40634, which may be created in the process described in the SGO scoring module 40626 in which the average profits for each skilled game operator or agent may be determined and stored in the SGO profit database 40634 to determine the highest and lowest profitable skilled game operators or agents. The SGO profit database 40634 may contain the agent ID, such as JS123456, and the average profit, such as $35,000. The SGO profit database 40634 may rank the skilled game operators or agents from 1 to “n,” representing an infinite number of agents possible in some embodiments.

FIG. 407 illustrates the base module 40624. The process may begin with the base module 40624 initiating, at step 40700, the SGO scoring module 40626. For example, the SGO scoring module 40626 may filter the SGO correction database 40632 for the agent ID. For example, the SGO correction database 40632 may be filtered for the Agent ID JS123456 to see all the corrections inputted by that skilled game operator or agent. The SGO scoring module 40626 may determine the average profitability of the agent. For example, the SGO scoring module 40626 may add up all the profits corresponding to the entries with the same agent ID and divide the total number of profits by the number of entries to determine the agent's average profit when they make an adjustment or correction. The SGO scoring module 40626 may store the average profitability in the SGO profits database 40634. For example, the SGO scoring module 40626 may store the agent ID, such as JS123456, with an average profit of $35,000. The SGO scoring module 40626 may determine if there are more SGOs in the SGO correction database 40632. For example, the SGO scoring module 40626 may determine if there are any other skilled game operators or agents who need their average profitability determined. If more agents remain in the SGO correction database 40632, the SGO scoring module 40626 may filter the SGO correction database 40632 for the next agent ID, and the process may return to determining the average profitability for the next agent. If there are no more agents remaining in the SGO correction database 40632, the SGO scoring module 40626 may sort the SGO profit database 40634 by the average profitability. The SGO scoring module 40626 may extract the ten lowest profitable agent IDS. For example, the SGO scoring module 40626 may select the lowest average profitable agents to provide a weighted score for the process described in the wager correlation module 40628, so only the best performing skilled game operators or agent's odds are used in the correlations. In some embodiments, there may be another number selected to remove the lowest profitable agents such as 5, 15, 20, etc. In some embodiments, the agents remaining may need to reach a certain profitability threshold to be selected, such as average profitability over a predetermined threshold such as $30,000 per wager adjustment. The SGO scoring module 40626 may remove the data entries with extracted agent IDs. For example, any agent determined to be the lowest profitable agents may have their data entries removed from the SGO correction database 40632 so that they are not used in the process described in the wager correlation module 40628 to provide a more refined dataset for the correlations. The SGO scoring module 40626 may return to the base module 40624. The base module 40624 may initiate, at step 40702, the wager correlation module 40628. For example, the wager correlation module 40628 may receive the situational data from the live event 40602. For example, the received situational data may be the Boston Red Sox J. D. Martinez up to bat in the first inning, and the third pitch of the at-bat. In some embodiments, the situational data received may be information related to the current state of the live event 40602, such as the time within the live event 40602, the teams involved, the players involved, etc. The wager correlation module 40628 may filter the odds database 40620 for the received situational data. For example, the odds database 40620 may be filtered for the Boston Red Sox J. D. Martinez up to bat in the first inning, and with the third pitch of the at-bat and the event being J. D. Martinez hitting a single so that the remaining data are the historical wager odds for the previous situations in which J. D. Martinez hit a single on the third pitch of the at-bat. The wager correlation module 40628 may extract the data from the odds database 40620. For example, the extracted data may be the historical wager odds and profits from the historical instances in which J. D. Martinez hit a single on the third pitch of the at-bat. The wager correlation module 40628 may filter the SGO correction database 40632 for the received situational data. For example, the SGO correction database 40632 may be filtered for the Boston Red Sox J. D. Martinez up to bat in the first inning, with the third pitch of the at-bat and the event being J. D. Martinez hitting a single so that the remaining data are the historical wager odds for the previous situations in which J. D. Martinez hit a single on the third pitch of the at-bat. The wager correlation module 40628 may extract the data from the SGO correction database 40632. For example, the extracted data may be the historical wager odds and profits in which an SGO inputted their own wager odds for J. D. Martinez to hit a single on the third pitch of the at-bat. The wager correlation module 40628 may perform correlations on the extracted data from the odds database 40620 and the SGO correction database 40632. For example, the extracted data may be for J. D. Martinez to hit a single in the first inning on the third pitch of the at-bat, and then correlations may be performed on the wager odds and profits for those wager odds in that situation. An example of correlated parameters may be with the wager odds vs. profits with a 0.97 correlation coefficient, and the most reoccurring data point may be extracted, for example, the wager odds being 2:1 with a profit of $20,000 and these wager odds, such as 2:1, may be sent to the SGO review module 40630 for the SGO to either accept or input their own wager odds for the situation. Another example may be if the situational data is the Boston Red Sox J. D. Martinez up to bat in the first inning, and with the third pitch of the at-bat and the event being a home run. An example of the correlated data may be with the wager odds vs. profits with a correlation coefficient of 0.95, and the most reoccurring data point may be extracted, for example, the wager odds being 6:1 with a profit of $35,000 and these wager odds, such as 6:1, may be sent to the SGO review module 40630 for the SGO to either accept or input their own wager odds for the situation. An example of uncorrelated data may be if the situational data was the Boston Red Sox J. D. Martinez up to bat in the first inning, with the third pitch of the at-bat and the event being a stolen base by a runner and the correlated parameters of the wager odds vs. profits with a 0.54 correlation coefficient. This may result in the correlation coefficient not being a above a predetermined threshold and the wager odds from the odds database 40620, or in some embodiments the odds from the odds calculation module 40622, may be sent to the SGO review module 40630. The wager correlation module 40628 may determine if the correlation is above a predetermined threshold, for example, above a 0.75 correlation coefficient. For example, the predetermined threshold may be a correlation coefficient of 0.90, and if the correlations are performed on the wager odds vs. profits with the same situational data, then the most reoccurring data point may be extracted. The wager odds from the data point may be sent to the SGO review module 40630. If the correlation coefficient is below the 0.90 correlation coefficient, then the SGO review module 40630 may receive the wager odds from the odds database 40620, or in some embodiments, receive odds from the odds calculation module 40622. If the correlation coefficient is above the predetermined threshold, then the wager correlation module 40628 may extract the most reoccurring data point. For example, the predetermined threshold may be a correlation coefficient of 0.90, and if the correlations are performed on the wager odds vs. profits with the same situational data, then the most reoccurring data point may be extracted, and the wager odds from the data point may be sent to the SGO review module 40630. The wager correlation module 40628 may send the wager odds to the SGO review module 40630. For example, the wager odds that may be sent may be odds at 2:1 that Boston Red Sox J. D. Martinez up to bat in the first inning, and with the third pitch of the at-bat and the event being J. D. Martinez hitting a single. If the correlation coefficient is below the predetermined threshold, then the wager correlation module 40628 may send the wager odds from the odds database 40620 to the SGO review module 40630. In some embodiments, the wager odds may be the wager odds calculated in the odds calculation module 40622. The wager correlation module 40628 may return to the base module 40624. The base module 40624 may initiate, at step 40604, the SGO review module 40630. For example, the SGO review module 40630 may continuously poll for wager odds from the wager correlation module 40628. For example, the SGO review module 40630 may receive the wager odds for the SGO to review. The SGO review module 40630 may receive the wager odds from the wager correlation module 40628. For example, the wager odds for Boston Red Sox J. D. Martinez hitting a single in the first inning on the third pitch may be 2:1. The SGO review module 40630 may display the wager odds to the SGO. For example, the wager odds of 2:1 for Boston Red Sox J. D. Martinez hitting a single in the first inning on the third pitch may be displayed to the SGO. The SGO review module 40630 may determine if the SGO accepted the wager odds. For example, the SGO may accept the 2:1 wager odds, or the SGO may disagree with the presented wager odds and input their wager odds. If the SGO accepted the wager odds, then the wager odds may be offered on the wagering app 40610. If the SGO did not accept the wager odds, then the SGO may input the new wager odds. For example, the SGO may adjust the wager odds from 2:1 to 3:1. The SGO review module 40630 may offer the inputted wager odds on the wagering app 40610. The SGO review module 40630 may store the new odds in the SGO correction database 40632. For example, the SGO correction database 40632 may store the situational data such as the team being the Boston Red Sox, the player being J. D. Martinez, the inning being the 1st, the pitch being the 3rd, the event is to hit a single, and the wager odds being 3:1. The SGO review module 40630 may return to the base module 40624.

FIG. 408 illustrates the SGO scoring module 40626. The process may begin with the SGO scoring module 40626 being initiated, at step 40800, by the base module 40624. The SGO scoring module 40626 may filter, at step 40802, the SGO correction database 40632 for the agent ID. For example, the SGO correction database 40632 may be filtered for the Agent ID JS123456 to see all the corrections inputted by that skilled game operator or agent. The SGO scoring module 40626 may determine, at step 40804, the average profitability of the agent. For example, the SGO scoring module 40626 may add up all the profits corresponding to the entries with the same agent ID and then divide the total number of profits by the number of entries to determine the agent's average profit when they make an adjustment or correction. The SGO scoring module 40626 may store, at step 40806, the average profitability in the SGO profits database 40634. For example, the SGO scoring module 40626 may store the agent ID, such as JS123456, with an average profit of $35,000. The SGO scoring module 40626 may determine, at step 40808, if more SGOs in the SGO correction database 40632. For example, the SGO scoring module 40626 may determine if any other skilled game operators or agents need their average profitability determined. If more agents remain in the SGO correction database 40632, the SGO scoring module 40626 may filter, at step 40810, the SGO correction database 40632 for the next agent ID, and the process may return to step 40804. If there are no more agents remaining in the SGO correction database 40632, the SGO scoring module 40626 may sort, at step 40812, the SGO profit database 40634 by the average profitability. The SGO scoring module 40626 may extract, at step 40814, the ten lowest profitable agent IDS. For example, the SGO scoring module 40626 may select the lowest average profitable agents to provide a weighted score for the process described in the wager correlation module 40628, so only the best performing skilled game operators or agent's odds are used in the correlations. In some embodiments, there may be another number selected to remove the lowest profitable agents such as 5, 15, 20, etc. In some embodiments, the agents remaining may need to reach a certain profitability threshold to be selected, such as average profitability over a predetermined threshold such as $30,000 per wager adjustment. The SGO scoring module 40626 may remove, at step 40816, the data entries with extracted agent IDs. For example, any agent determined to be the lowest profitable agents may have their data entries removed from the SGO correction database 40632 so that they are not used in the process described in the wager correlation module 40628 to provide a more refined dataset for the correlations. The SGO scoring module 40626 may return, at step 40818, to the base module 40624.

FIG. 409 illustrates the wager correlation module 40628. The process may begin with the wager correlation module 40628 being initiated, at step 40900, by the base module 40624. The wager correlation module 40628 may receive, at step 40902, the situational data from the live event 40602. For example, the received situational data may be the Boston Red Sox J. D. Martinez up to bat in the first inning, and with the third pitch of the at-bat. In some embodiments, the situational data received may be information related to the current state of the live event 40602, such as the time within the live event 40602, the teams involved, the players involved, etc. The wager correlation module 40628 may filter, at step 40904, the odds database 40620 for the received situational data. For example, the odds database 40620 may be filtered having the Boston Red Sox J. D. Martinez up to bat in the first inning, with the third pitch of the at-bat and the event being J. D. Martinez hitting a single so that the remaining data are the historical wager odds for the previous situations in which J. D. Martinez hit a single on the third pitch of the at-bat. The wager correlation module 40628 may extract, at step 40906, the data from the odds database 40620. For example, the extracted data may be the historical wager odds and profits from the historical instances in which J. D. Martinez hit a single on the third pitch of the at-bat. The wager correlation module 40628 may filter, at step 40908, the SGO correction database 40632 for the received situational data. For example, the SGO correction database 40632 may be filtered having the Boston Red Sox J. D. Martinez up to bat in the first inning, with the third pitch of the at-bat and the event being J. D. Martinez hitting a single so that the remaining data are the historical wager odds for the previous situations in which J. D. Martinez hit a single on the third pitch of the at-bat. The wager correlation module 40628 may extract, at step 40910, the data from the SGO correction database 40632. For example, the extracted data may be the historical wager odds and/or profits in which an SGO inputted their own wager odds for J. D. Martinez to hit a single on the third pitch of the at-bat. The wager correlation module 40628 may perform, at step 40912, correlations on the extracted data from the odds database 40620 and the SGO correction database 40632. For example, the extracted data may be for J. D. Martinez to hit a single in the first inning on the third pitch of the at-bat, and then correlations may be performed on the wager odds and profits for those wager odds in that situation. An example of correlated parameters may be with the wager odds vs. profits with a 0.97 correlation coefficient, and the most reoccurring data point may be extracted, for example, the wager odds being 2:1 with a profit of $20,000 and these wager odds, such as 2:1, may be sent to the SGO review module 40630 for the SGO to either accept or input their own wager odds for the situation. Another example may be if the situational data is the Boston Red Sox J. D. Martinez up to bat in the first inning, and with the third pitch of the at-bat and the event being a home run. An example of the correlated data may be the wager odds vs. profits with a correlation coefficient of 0.95, and the most reoccurring data point may be extracted. For example, the wager odds being 6:1 with a profit of $35,000 and these wager odds, such as 6:1, may be sent to the SGO review module 40630 for the SGO to either accept or input their own wager odds for the situation. An example of uncorrelated data may be in if the situational data was the Boston Red Sox J. D. Martinez up to bat in the first inning and with the third pitch of the at-bat and the event being a stolen base by a runner and the correlated parameters of the wager odds vs. profits with a 0.54 correlation coefficient. This may result in the correlation coefficient not being a above a predetermined threshold and the wager odds from the odds database 40620, or in some embodiments the odds from the odds calculation module 40622, may be sent to the SGO review module 40630. The wager correlation module 40628 may determine, at step 40914, if the correlation is above a predetermined threshold, for example, above a 0.75 correlation coefficient. For example, the predetermined threshold may be a correlation coefficient of 0.90, and if the correlations are performed on the wager odds vs. profits with the same situational data, then the most reoccurring data point may be extracted. The wager odds from the data point are sent to the SGO review module 40630. If the correlation coefficient is below the 0.90 correlation coefficient, then the SGO review module 40630 will receive the wager odds from the odds database 40620, or in some embodiments, receive odds from the odds calculation module 40622. If the correlation coefficient is above the predetermined threshold, then the wager correlation module 40628 may extract, at step 40916, the most reoccurring data point. For example, the predetermined threshold may be a correlation coefficient of 0.90, and if the correlations are performed on the wager odds vs. profits with the same situational data, then the most reoccurring data point may be extracted, and the wager odds from the data point may be sent to the SGO review module 40630. The wager correlation module 40628 may send, at step 40918, the wager odds to the SGO review module 40630. For example, the wager odds that may be sent may be odds at 2:1 that Boston Red Sox J. D. Martinez up to bat in the first inning, and the third pitch of the at-bat and the event being a single. If the correlation coefficient is below the predetermined threshold, then the wager correlation module 40628 may send, at step 40920, the wager odds from the odds database 40620 to the SGO review module 40630. In some embodiments, the wager odds may be the wager odds calculated in the odds calculation module 40622. The wager correlation module 40628 may return, at step 40922, to the base module 40624.

FIG. 410 illustrates the SGO review module 40630. The process may begin with the SGO review module 40630 being initiated, at step 41000, by the base module 40624. The SGO review module 40630 may continuously poll, at step 41002, for wager odds from the wager correlation module 40628. For example, the SGO review module 40630 may receive the wager odds for the SGO to review. The SGO review module 40630 may receive, at step 41004, the wager odds from the wager correlation module 40628. For example, the wager odds for Boston Red Sox J. D. Martinez hitting a single in the first inning on the third pitch may be 2:1. The SGO review module 40630 may display, at step 41006, the wager odds to the SGO. For example, the wager odds of 2:1 for Boston Red Sox J. D. Martinez to hit a single in the first inning on the third pitch may be displayed to the SGO. The SGO review module 40630 may determine, at step 41008, if the SGO accepted the wager odds. For example, the SGO may accept the 2:1 wager odds, or the SGO may disagree with the presented wager odds and input their wager odds. If the SGO accepted the wager odds, then the wager odds may be offered, at step 41010, on the wagering app 40610 and may skip to step 41018. If the SGO did not accept the wager odds, then the SGO may input, at step 41012, the new wager odds. For example, the SGO may adjust the wager odds from 2:1 to 3:1. The SGO review module 40630 may offer, at step 41014, the inputted wager odds on the wagering app 40610. The SGO review module 40630 may store, at step 41016, the new odds in the SGO correction database 40632. For example, the SGO correction database 40632 may store the situational data such as the team being the Boston Red Sox, the player being J. D. Martinez, the inning being the 1st, the pitch being the 3rd, the event is to hit a single, and the wager odds being 3:1. The SGO review module 40630 may return, at step 41018, to the base module 40624.

FIG. 411 illustrates the SGO correction database 40632. The SGO correction database 40632 may be created from the process described in the SGO review module 40630, in which when an SGO may input new wager odds for a wager, the situational data from the event and the wager as well as profits from that wager are stored in the SGO correction database 40632. The SGO correction database 40632 may contain the situational data, such as the action ID, the team, the player, the inning, time of the event, the pitch number, the event. The SGO correction database 40632 may also store the parameters such as the agent ID, the wager odds, and the profit amount.

FIG. 412 illustrates the SGO profit database 40634. The SGO profit database 134 may be created in the process described in the SGO scoring module 40626, in which the average profits for each skilled game operator or agent may be determined and stored in the SGO profit database 40634 to determine the highest and lowest profitable skilled game operators or agents. The SGO profit database 40634 may contain the agent ID, such as JS123456, and the average profit, such as $35,000. In some embodiments, the SGO profit database 40634 may rank the skilled game operators or agents from 1 to “n,” representing an infinite number of agents possible.

FIG. 413 illustrates a system for calculating the odds of a sports play using data fidelity, according to an embodiment.

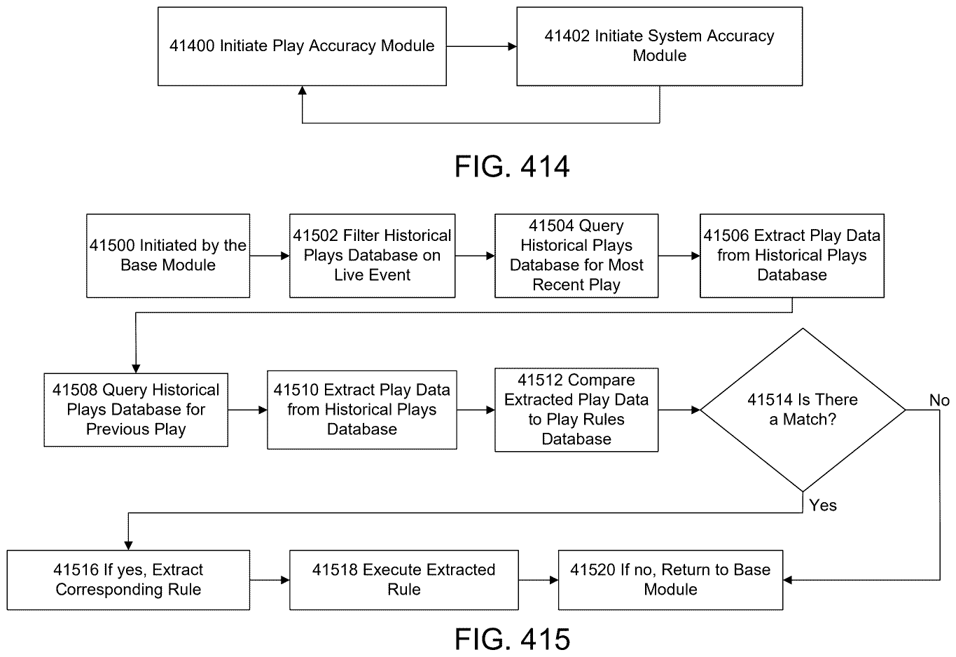

FIG. 414 illustrates a base module, according to an embodiment.

FIG. 415 illustrates a play accuracy module, according to an embodiment.

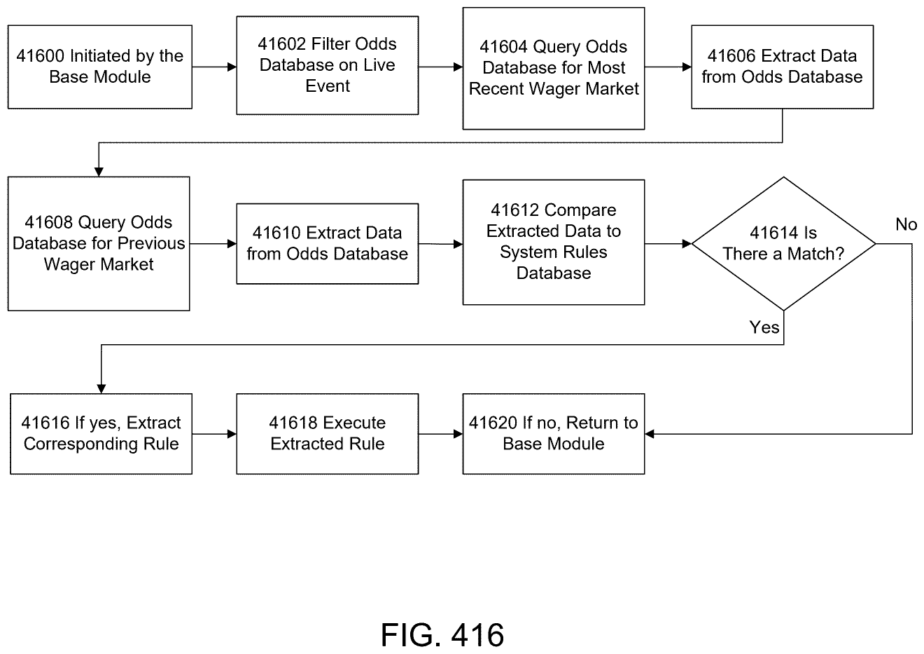

FIG. 416 illustrates a system accuracy module, according to an embodiment.

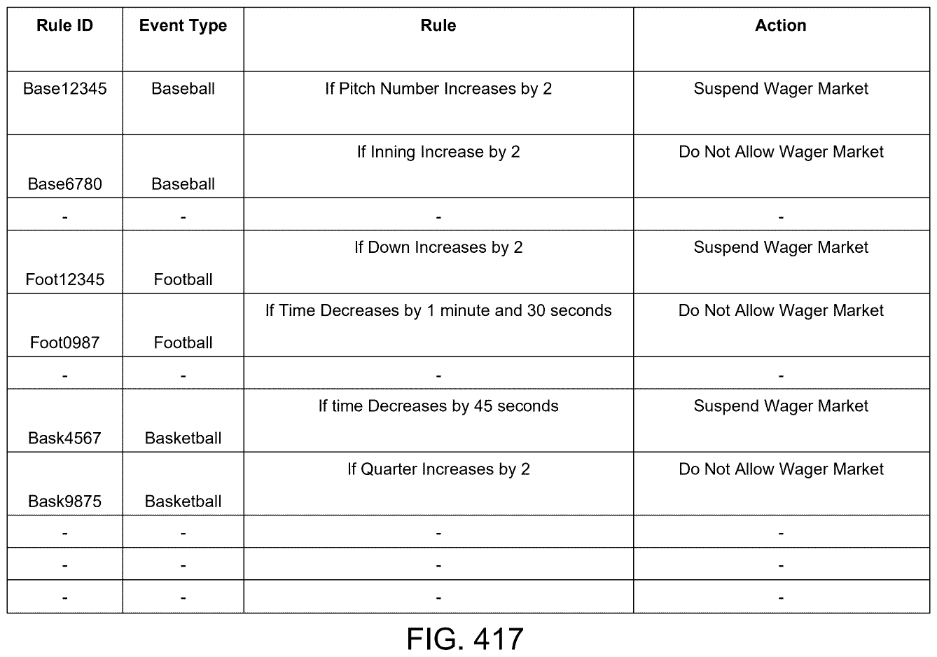

FIG. 417 illustrates a play rules database, according to an embodiment.

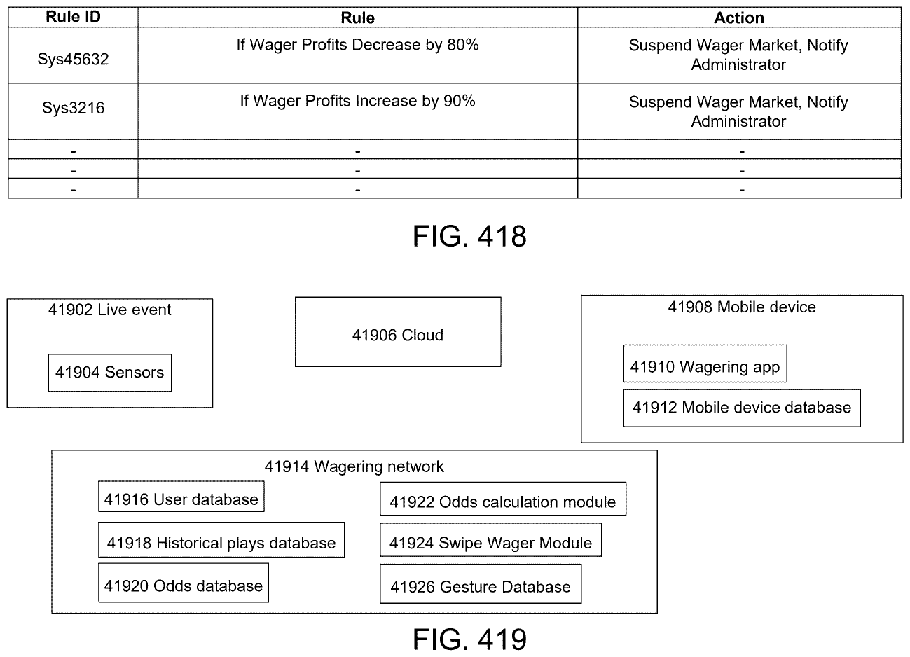

FIG. 418 illustrates a system rules database, according to an embodiment.

FIG. 413 is a system for calculating the odds of a sports play using data fidelity. This system may include a live event 41302, for example, a sporting event such as a football, basketball, baseball, or hockey game, tennis match, golf tournament, eSports, or digital game, etc. The live event 41302 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 41302, such as the score of an American football game or the run line in a baseball game, or a series of actions in the live event 41302. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 41302 or at another location.

Further, embodiments may include a plurality of sensors 41304 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 41304 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 41306 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 41306 may be communicatively coupled to a wagering network 41314, which may perform real-time analysis on the type of play and the result of the play. The cloud 41306 may also be synchronized with game situational data such as the time of the game, the score, location on the field, weather conditions, and the like, which may affect the choice of play utilized. For example, in an exemplary embodiment, the cloud 41306 may not receive data gathered from the sensors 41304 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 41308 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 41308 could be an optional component and would be utilized in a situation where a paired wearable device employs the mobile device 41308 for additional memory or computing power or connection to the internet.

Further, embodiments may include a wagering software application or a wagering app 41310, which is a program that enables the user to place bets on individual plays in the live event 41302, streams audio and video from the live event 41302, and features the available wagers from the live event 41302 on the mobile device 41308. The wagering app 41310 allows the user to interact with the wagering network 41314 to place bets and provide payment/receive funds based on wager outcomes.

Further, embodiments may include a mobile device database 41312 that may store some or all the user's data, the live event 41302, or the user's interaction with the wagering network 41314.

Further, embodiments may include the wagering network 41314, which may perform real-time analysis on the type of play and the result of a play or action. The wagering network 41314 (or the cloud 41306) may also be synchronized with game situational data, such as the time of the game, the score, location on the field, weather conditions, and the like, which may affect the choice of play utilized. For example, in an exemplary embodiment, the wagering network 41314 may not receive data gathered from the sensors 41304 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 41314 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 41316, which may contain data relevant to all users of the wagering network 41314 and may include, but is not limited to, a user ID, a device identifier, a paired device identifier, wagering history, or wallet information for the user. The user database 41316 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 41316 may contain betting lines and search queries. The user database 41316 may be searched based on a search criterion received from the user. Each betting line may include but is not limited to, a plurality of betting attributes such as at least one of the following: the live event 41302, a team, a player, an amount of wager, etc. The user database 41316 may include, but is not limited to, information related to all the users involved in the live event 41302. In one exemplary embodiment, the user database 41316 may include information for generating a user authenticity report and a wagering verification report. Further, the user database 41316 may be used to store user statistics like, but not limited to, the retention period for a particular user, frequency of wagers placed by a particular user, the average amount of wager placed by each user, etc.

Further, embodiments may include a historical plays database 41318 that may contain play data for the type of sport being played in the live event 41302. For example, in American Football, for optimal odds calculation, the historical play data may include data or metadata about the live event and/or historical plays, such as time, location, weather, previous plays, scores, winners, losers, opponent data, physiological data, team record data, etc. Further, embodiments may utilize an odds database 41320—that contains the odds calculated by an odds calculation module 41322—to display the odds on the user's mobile device 41308 and take bets from the user through the mobile device wagering app 41310.

Further, embodiments may include the odds calculation module 41322, which utilizes historical play data to calculate odds for in-play wagers.

Further, embodiments may include a base module 41324, which may begin with the base module 41324 initiating the play accuracy module 41326. For example, the play accuracy module 41326 may filter the historical plays database 41318 for the live event 41302. The play accuracy module 41326 may query the historical plays database 41318 for the most recent play or entry. The play accuracy module 41326 may extract the play data from the historical play database 41318. The play accuracy module 41326 may query the historical plays database 41318 for the previous play data. The play accuracy module 41326 may extract the previous play data from the historical plays database 41318. The play accuracy module 41326 may compare the extracted play data with the play rules database 41330. The play accuracy module 41326 may determine if a match exists between the extracted play data and the rules stored in the play rules database 41330. If there is a match, the play accuracy module 41326 may extract the corresponding rule from the play rules database 41330. The play accuracy module 41326 may execute the extracted rule from the play rules database 41330. If there is no match or after the extracted rule is executed, the play accuracy module 41326 may return to the base module 41324. The base module 41324 may initiate the system accuracy module 41328. The system accuracy module 41328 may filter the odds database 41320 for the live event 41302. The system accuracy module 41328 may query the odds database 41320 for the most recent wager market or odds. The system accuracy module 41328 may extract the wager market data from the odds database 41320. The system accuracy module 41328 may query the odds database 41320 for the previous wager market data. The system accuracy module 41328 may extract the previous wager market data from the odds database 41320. The system accuracy module 41328 may compare the extracted wager market data with the system rules database 41332. The system accuracy module 41328 may determine if there is a match between the extracted wager market data and the rules stored in the system rules database 41332. If there is a match, the system accuracy module 41328 may extract the corresponding rule from the system rules database 41332. The system accuracy module 41328 may execute the extracted rule from the system rules database 41332. If there is no match or after the extracted rule is executed, the system accuracy module 41328 may return to the base module 41324.

Further, embodiments may include a play accuracy module 41326, which may begin with the base module 41324 initiating the play accuracy module 41326. The play accuracy module 41326 may filter the historical plays database 41318 for the live event 41302. For example, if the live event 41302 is the Boston Red Sox vs. the New York Yankees, the historical plays database 41318 may be filtered for all historical plays for the Boston Red Sox vs. the New York Yankees. The play accuracy module 41326 may query the historical plays database 41318 for the most recent play or entry. For example, the most recent play may be in the Boston Red Sox vs. the New York Yankees event in the bottom of the second inning, with the number three batter up at the plate, such as J. D. Martinez, with one out and no runners on base, and five pitches have been thrown. The play accuracy module 41326 may extract the play data from the historical play database 41318. For example, the extracted play data may be the Boston Red Sox vs. the New York Yankees event in the bottom of the second inning, with the number three batter up at the plate, such as J. D. Martinez, with one out and no runners on base, and five pitches have been thrown. The play accuracy module 41326 may query the historical plays database 41318 for the previous play data. For example, the play accuracy module 41326 may query the historical plays database 41318 for the second most recent play, the second newest entry in the historical plays database 41318, or the data entry previously entered before the most recent play. The play accuracy module 41326 may extract the previous play data from the historical plays database 41318. For example, the data extracted may be the Boston Red Sox vs. the New York Yankees event in the bottom of the second inning, with the number three batter up at the plate, such as J. D. Martinez, with one out and no runners on base, and three pitches have been thrown. The play accuracy module 41326 may compare the extracted play data to the play rules database 41330. For example, the play accuracy module 41326 may compare the extracted play data to the play rules database 41330 to determine the differences between the two data entries, such as the number of pitches increased since the most recent entry. The play accuracy module 41326 may determine if there is an associated rule with the difference in data. Another example may be if the inning from the most recent data entry was the bottom of the fourth inning and the second most recent data entry has the live event 41302 in the top of the second inning, meaning an increase of two innings. The play accuracy module 41326 may determine if there is a match between the extracted play data and the rules stored in the play rules database 41330. For example, if the number of pitches increased by two since the previous data entry, there may be a match with the data stored in the play rules database 41330, thereby causing the corresponding action to be extracted and executed. Similarly, if the innings increased by two, there may also be a match to the data stored in the play rules database 41330, thereby causing the corresponding action to be extracted and executed. If there is a match, the play accuracy module 41326 may extract the corresponding rule from the play rules database 41330. For example, if the number of pitches increased by two from the previous data entry and the most recent data entry, there may be a match, and the corresponding action may be to suspend the wagering market. For example, the wagering market may not offer wager odds to the user until there are no matches between the differences in the two data entries and play rules database 41330 thereby ensuring that the data received by the wagering network 41314 is correct and without error. The play accuracy module 41326 may execute the extracted rule from the play rules database 41330. For example, the corresponding rule or corresponding action may be to suspend the wagering market. In another example, the wagering market may not offer wager odds to the user until there were no matches between the differences in the two data entries and play rules database 41330 thereby ensuring that the data being received by the wagering network 41314 is correct and without error. If there is no match or after the extracted rule is executed, the play accuracy module 41326 may return to the base module 41324.

Further, embodiments may include a system accuracy module 41328, which may begin with the base module 41324 initiating the system accuracy module 41328. The system accuracy module 41328 may filter the odds database 41320 for the live event 41302. For example, the system accuracy module 41328 may filter the odds database 41320 for the live event 41302 of the Boston Red Sox vs. the New York Yankees. The system accuracy module 41328 may query the odds database 41320 for the most recent wager market or odds. For example, the system accuracy module 41328 may query the odds database 41320 for the most recent wager market or odds offered for the live event 41302, such as the in the second inning of the Boston Red Sox vs. the New York Yankees event with J. D. Martinez at-bat, the fifth pitch was a ball, resulting in the house or the wagering network 41314 collecting $10,000. The system accuracy module 41328 may extract the wager market data from the odds database 41320. For example, the data extracted may be in the second inning in the Boston Red Sox vs. the New York Yankees event with J. D. Martinez at-bat, wherein the fifth pitch was a ball that resulted in the wagering network 41314 collecting $10,000. The system accuracy module 41328 may query the odds database 41320 for the previous wager market data. For example, the system accuracy module 41328 may query the odds database 41320 for the wager odds data for the wagering market before the most recent wager market or the second most recent data entry in the odds database 41320. For example, the data may be in the second inning in the Boston Red Sox vs. the New York Yankees event with J. D. Martinez at-bat, wherein the fourth pitch was a ball, resulting in the house or the wagering network 41314 collecting $50,000. The system accuracy module 41328 may extract the previous wager market data from the odds database 41320. For example, the data extracted may be in the second inning in the Boston Red Sox vs. the New York Yankees event with J. D. Martinez at-bat, wherein the fourth pitch was a ball, resulting in the wagering network 41314 collecting $50,000. The system accuracy module 41328 may compare the extracted wager market data to the system rules database 41332. For example, the system accuracy module 41328 may compare the two extracted data entries in which the difference is on the fourth pitch where the house or wagering network 41314 collected $50,000, and on the fifth pitch, where the house collected $10,000 on the wagers for the pitch to be a ball, which may be a decrease of 80% in collections or profits for the house. The system accuracy module 41328 may determine if there is a match between the extracted wager market data and the rules stored in the system rules database 41332. For example, the difference between the two data entries may be that the house profits decreased by 80%, so there may be a match between the two data entries and the data stored in the system rules database 141332, which may result in the corresponding action to be extracted and executed. If there is a match, the system accuracy module 41328 may extract the corresponding rule from the system rules database 41332. For example, the difference between the two data entries may be that the house profits decreased by 80%, so there may be a match between the two data entries and the data stored in the system rules database 41332, which may result in the corresponding action, such as the wagering market being suspended, or a system administrator being notified. The decrease in profits for the house or wagering network 41314 may be because of incorrect or erroneous data received by the wagering network 41314 to create the odds, thereby potentially resulting in inappropriate or incorrect wager odds that either make the house lose profits drastically or allow the house to collect profits drastically; this may in turn lower user engagement due to a lack of trust in the system. The system accuracy module 41328 may execute the extracted rule from the system rules database 41332. For example, the corresponding action may be to suspend the wagering market or notify an administrator to correct the wager odds or check the system to ensure that the data being received from the live event 41302 is correct and without errors thereby potentially preventing further drastically increased or decreased profits for the wagering network 41314. If there is no match or after the extracted rule is executed, the system accuracy module 41328 may return to the base module 41324.

Further, embodiments may include a play rules database 41330. The play rules database 41330 may contain the rule ID, such as Basel 2354, the event type, such as baseball, the rule, such as if the pitch number increases by two, and the action, such as suspend the wagering market. The play rules database 41330 may be used in the process described in the play accuracy module 41326, wherein the two most recent plays from a live event 41302 are extracted from the historical plays database 41318 and compared to the play rules database 41330 to determine if the two extracted data entries match any of the rules listed and if so, execute the corresponding action. This comparison may prevent the wagering network 41314 from using erroneous data from the live event 41302, which may lead to the creation of inappropriate or wrong wagering odds or wagering odds that do not fully represent the current state of the live event 41302. In some embodiments, the play rules database 41330 may contain data for multiple sports or events such as baseball, football, soccer, hockey, tennis, golf, etc. In some embodiments, the play rules database 41330 may contain other rules or actions that limit or suspend wager markets until the data being received is deemed correct, or if there is a continuous stream of incorrect data, then the play rules database 41330 may contain an action to inform or notify a system administrator to correct the data being received or perform some other action to correctly create wagering odds for the live event 41302.

Further, embodiments may include a system rules database 41332. The system rules database 41332 may contain the rule ID, such as Sys45632, the rule, such as if wager profits decrease by 80%, and the action, such as suspend the wagering market and notify a system administrator. The system rules database 41332 may be used in the process described in the system accuracy module 41328, wherein which the two most wager markets for the live event 41302 are extracted from the odds database 41320 and compared to the system rules database 41332 to determine if the two extracted data entries match any of the rules listed and if so, execute the corresponding action. This comparison may prevent the wagering network 41314 from using data from the live event 41302 that may be erroneous, leading to the creation of inappropriate or wrong wagering odds or wagering odds that do not fully represent the current state of the live event 41302. The system rules database 41332 may contain rules based on potential system errors that may be caused by receiving incorrect or error-filled data from the live event 41302 that may potentially have a drastic outcome on the profits or losses for the wagering network 41314. This may lead the wagering network 41314 to incorrectly losing large sums of profits or gaining profits incorrectly, thereby potentially leading to mistrust with users and loss of user engagement. In some embodiments, the system rules database 41332 may contain other rules or actions that limit or suspend wagering markets until the data being received is deemed correct. If there is a continuous stream of incorrect data, the system rules database 41332 may contain an action to inform or notify a system administrator to correct the data being received or perform some other action to correctly create wagering odds for the live event 41302.

FIG. 414 illustrates the base module 41324. The process may begin with the base module 41324 initiating, at step 41400, the play accuracy module 41326. The base module 41324 may then initiate, at step 41402, the system accuracy module 41328.

FIG. 415 illustrates the play accuracy module 41326. The process may begin with the base module 41324 initiating, at step 41500, the play accuracy module 41326. The play accuracy module 41326 may filter, at step 41502, the historical plays database 41318 for the live event 41302. For example, if the live event 41302 is the Boston Red Sox vs. the New York Yankees, the historical plays database 41318 may be filtered for all historical plays for the Boston Red Sox vs. the New York Yankees. The play accuracy module 41326 may query, at step 41504, the historical plays database 41318 for the most recent play or entry. For example, the most recent play may be in the Boston Red Sox vs. the New York Yankees event in the bottom of the second inning, with the number three batter up at the plate, such as J. D. Martinez, with one out and no runners on base, and five pitches have been thrown. The play accuracy module 41326 may extract, at step 41506, the play data from the historical play database 41318. For example, the extracted data may be the Boston Red Sox vs. the New York Yankees event in the bottom of the second inning, with the number three batter up at the plate, such as J. D. Martinez, with one out and no runners on base, and five pitches have been thrown. The play accuracy module 41326 may query, at step 41508, the historical plays database 41318 for the previous play data. For example, the play accuracy module 41326 may query the historical plays database 41318 for the second most recent play, the second newest entry in the historical plays database 41318, or the data entry previously entered before the most recent play. The play accuracy module 41326 may extract, at step 41510, the previous play data from the historical plays database 41318. For example, the extracted data may be the Boston Red Sox vs. the New York Yankees event in the bottom of the second inning, with the number three batter up at the plate, such as J. D. Martinez, with one out and no runners on base, and three pitches have been thrown. The play accuracy module 41326 may compare, at step 41512, the extracted play data with the play rules database 41330. For example, the comparison may determine the differences between the two data entries, such the number of pitches has increased by two or that the most recent entry has five pitches thrown and the previous entry from that has three pitches thrown. So, the two-pitch increase may be compared to the play rules database 41330 to determine if there is an associated rule with the difference in data. Another example may be that the inning from the most recent data entry was the bottom of the fourth inning and the second most recent data entry has the event in the top of the second inning, which may be an increase of two innings. The play accuracy module 41326 may determine, at step 41514, if there is a match between the extracted play data and the rules stored in the play rules database 41330. For example, if the number of pitches increased by two from the previous data entry and the most recent data entry, there may be a match to the data stored in the play rules database 41330, and the corresponding action may be extracted and executed. Similarly, if the innings increased by two, there may also be a match to the data stored in the play rules database 41330, and the corresponding action may be extracted and executed. If there is a match, the play accuracy module 41326 may extract, at step 41516, the corresponding rule from the play rules database 41330. For example, if the number of pitches increased by two from the previous data entry and the most recent data entry, there may be a match, and the corresponding action may be to suspend the wagering market. For example, the wagering market may not offer wager odds to the user until there were no matches between the differences in the two data entries and play rules database 41330 thereby ensuring that the data being received by the wagering network 41314 is correct and without error. The play accuracy module 41326 may execute, at step 41518, the extracted rule from the play rules database 41330. For example, the corresponding rule or corresponding action may be to suspend the wagering market. For example, the wagering market may not offer wager odds to the user until there were no matches between the differences in the two data entries and play rules database 41330 to ensure that the data being received by the wagering network 41314 is correct and without error. If there is no match or after the extracted rule is executed, the play accuracy module 41326 may return, at step 41520, to the base module 41324.

FIG. 416 illustrates the system accuracy module 41328. The process may begin with the base module 41324 initiating, at step 41600, the system accuracy module 141328. The system accuracy module 41328 may filter, at step 41602, the odds database 41320 for the live event 41302. For example, the system accuracy module 41328 may filter the odds database 41320 for the live event 41302 of the Boston Red Sox vs. the New York Yankees. The system accuracy module 41328 may query, at step 41604, the odds database 41320 for the most recent wager market or wager odds. For example, the system accuracy module 41328 may query the odds database 41320 for the most recent wager market, or the most recent odds offered on the live event 41302, such as the in the second inning in the Boston Red Sox vs. the New York Yankees event with J. D. Martinez at-bat the fifth pitch was a ball which may result in the house or the wagering network 41314 collecting $10,000. The system accuracy module 41328 may extract, at step 41506, the wager market data from the odds database 41320. For example, the data extracted may be in the second inning in the Boston Red Sox vs. the New York Yankees event with J. D. Martinez at-bat, wherein the fifth pitch was a ball, resulting in the house or the wagering network 41314 collecting $10,000. The system accuracy module 41328 may query, at step 41608, the odds database 41320 for the previous wager market data. For example, the system accuracy module 41328 may query the odds database 41320 for the wager odds data for the wagering market before the most recent wager market or the second most recent data entry in the odds database 41320. For example, the data may be in the second inning in the Boston Red Sox vs. the New York Yankees event with J. D. Martinez at-bat the fourth pitch was a ball which may result in the house or the wagering network 41314 collecting $50,000. The system accuracy module 41328 may extract, at step 41610, the previous wager market data from the odds database 41320. For example, the data extracted may be in the second inning in the Boston Red Sox vs. the New York Yankees event with J. D. Martinez at-bat the fourth pitch was a ball that resulted in the house or the wagering network 41314 collecting $50,000. The system accuracy module 41328 may compare, at step 41612, the extracted wager market data to the system rules database 41332. For example, the system accuracy module 41328 may compare the two extracted data entries in which the difference is on the fourth pitch the house or wagering network 41314 collected $50,000, and on the fifth pitch, the house collected $10,000 on the wagers for the pitch to be a ball, which may be a decrease of 80% in collections or profits for the house. The system accuracy module 41328 may determine, at step 41614, if there is a match between the extracted wager market data and the rules stored in the system rules database 41332. For example, the difference between the two data entries is that the house profits decreased by 80%, so there may be a match between the two data entries and the data stored in the system rules database 41332, which may result in the corresponding action to be extracted and executed. If there is a match, the system accuracy module 41328 may extract, at step 41616, the corresponding rule from the system rules database 41332. For example, the difference between the two data entries is the house profits decreased by 80%, so there may be a match between the two data entries and the data stored in the system rules database 41332, which may result in the corresponding action, such as the wagering market being suspended, and a system administrator being notified. The decrease in profits for the house or wagering network 41314 may be because the wagering network 41314 received incorrect or erroneous data used to create the odds thereby potentially resulting in inappropriate or incorrect wager odds that may either make the house lose profits drastically or allow the house to collect profits drastically which may lower user engagement due to a lack of trust in the system. The system accuracy module 41328 may execute, at step 41618, the extracted rule from the system rules database 41332. For example, the corresponding action may be to suspend the wagering market and notify an administrator to correct the wager odds or check the system to ensure that the data being received from the live event 41302 is correct and does not contain errors to prevent further drastically increased or decreased profits for the wagering network 41314. If there is no match or after the extracted rule is executed, the system accuracy module 41328 may return, at step 41620, to the base module 41324.

FIG. 417 illustrates the play rules database 41330. The play rules database 41330 may contain the rule ID, such as Base 12354, the event type, such as baseball, the rule, such as if the pitch number increases by two, and the action, such as suspend the wagering market. The play rules database 41330 may be used in the process described in the play accuracy module 41326, wherein the two most recent plays from the live event 41302 are extracted from the historical plays database 41318 and compared to the play rules database 41330 to determine if the two extracted data entries match any of the rules listed and if so, execute the corresponding action. This comparison may prevent the wagering network 41314 from using data from the live event 41302 that may be considered erroneous, leading to the creation of inappropriate or wrong wagering odds or wagering odds that do not fully represent the current state of the live event 41302. In some embodiments, the play rules database 41330 may contain data for multiple sports or events such as baseball, football, soccer, hockey, tennis, golf, etc. In some embodiments, the play rules database 41330 may contain other rules or actions that limit or suspend wagering markets (or otherwise govern or control the wagering markets) until the data being received is deemed correct, or if there is a continuous stream of incorrect data, then the play rules database 41330 may contain an action to inform or notify a system administrator to correct the data being received or perform some other action to correctly create wagering odds for the live event 41302.

FIG. 418 illustrates the system rules database 41332. The system rules database 41332 may contain the rule ID, such as Sys45632, the rule, such as if wager profits decrease by 80%, and the action, such as suspend the wagering market and notify a system administrator, or other contain and execute a series of governing or controlling rules or actions. The system rules database 41332 may be used in the process described in the system accuracy module 41328, wherein the two most wager markets for the live event 41302 are extracted from the odds database 41320 and compared to the system rules database 41332 to determine if the two extracted data entries match any of the rules listed and if so, execute the corresponding action. This comparison may prevent the wagering network 41314 from using data from the live event 41302 that may be considered erroneous, leading to the creation of inappropriate or wrong wagering odds or wagering odds that do not fully represent the current state of the live event 41302. The system rules database 41332 may contain rules based on potential system errors that may be caused by receiving incorrect or error-filled data from the live event 41302 that may potentially have a drastic outcome on the profits or losses for the wagering network 41314, which may lead to the wagering network 41314 incorrectly losing large sums of profits or gaining profits incorrectly which may lead to mistrust with users and lead to less user engagement. In some embodiments, the system rules database 41332 may contain other controlling rules or actions that limit or suspend wagering markets until the data being received is deemed correct, or if there is a continuous stream of incorrect data, then the system rules database 41332 may contain an action to inform or notify a system administrator to correct the data being received or perform some other action to correctly create wagering odds for the live event 41302.

FIG. 419 illustrates a system for swipe-based wagering, according to an embodiment.

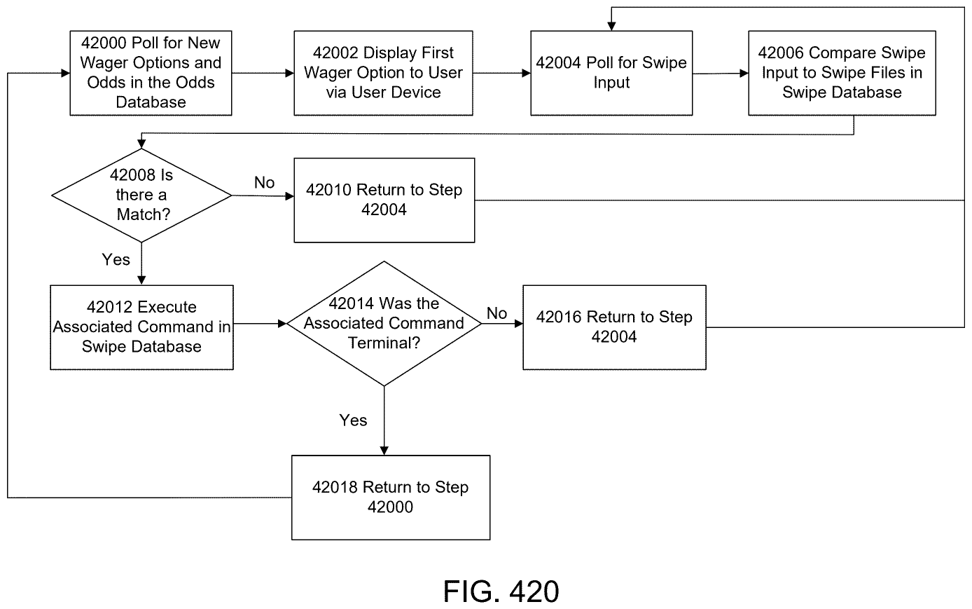

FIG. 420 illustrates a swipe wager module, according to an embodiment.

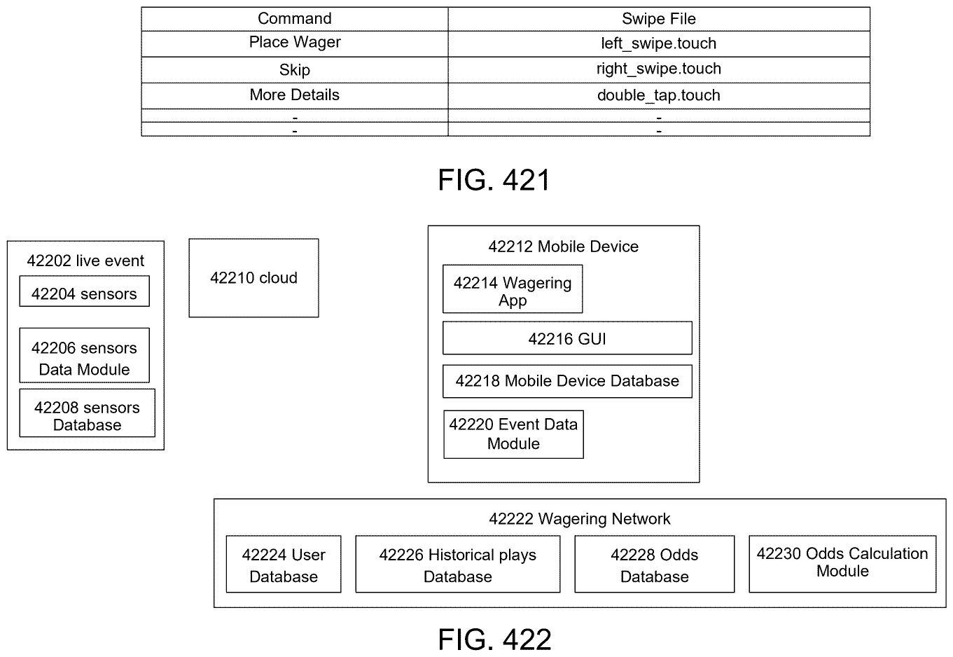

FIG. 421 illustrates a gesture database, according to an embodiment.

FIG. 419 is a system for swipe-based wagering. This system may include a live event 41902, for example, a sporting event such as a football, basketball, baseball, or hockey game, tennis match, golf tournament, eSports, or digital game, etc. The live event 41902 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 41902, such as the score of an American football game or the run line in a baseball game, or a series of actions in the live event 41902. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 41902 or at another location.

Further, embodiments may include a plurality of sensors 41904 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 41904 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 41906 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 41906 may be communicatively coupled to a peer-to-peer wagering network 41914, which may perform real-time analysis on the type of play and the result of the play. The cloud 41906 may also be synchronized with game situational data such as the time of the game, the score, location on the field, weather conditions, and the like, which may affect the choice of play utilized. For example, in an exemplary embodiment, the cloud 41906 may not receive data gathered from the sensors 41904 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 41908 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 41908 could be an optional component and would be utilized in a situation where a paired wearable device employs the mobile device 41908 for additional memory or computing power or connection to the internet.

Further, embodiments may include a wagering software application or a wagering app 41910, which is a program that enables the user to place bets on individual plays in the live event 41902, streams audio and video from the live event 41902, and features the available wagers from the live event 41902 on the mobile device 41908. The wagering app 41910 allows the user to interact with the wagering network 41914 to place bets and provide payment/receive funds based on wager outcomes.

Further, embodiments may include a mobile device database 41912 that may store some or all the user's data, the live event 41902, or the user's interaction with the wagering network 41914.

Further, embodiments may include the wagering network 41914, which may perform real-time analysis on the type of play and the result of a play or action. The wagering network 41914 (or the cloud 41906) may also be synchronized with game situational data, such as the time of the game, the score, location on the field, weather conditions, and the like, which may affect the choice of play utilized. For example, in an exemplary embodiment, the wagering network 41914 may not receive data gathered from the sensors 41904 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 41914 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 41916, which may contain data relevant to all users of the wagering network 41914 and may include, but is not limited to, a user ID, a device identifier, a paired device identifier, wagering history, or wallet information for the user. The user database 41916 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 41916 may contain betting lines and search queries. The user database 41916 may be searched based on a search criterion received from the user. Each betting line may include but is not limited to, a plurality of betting attributes such as at least one of the following: the live event 41902, a team, a player, an amount of wager, etc. The user database 41916 may include, but is not limited to, information related to all the users involved in the live event 41902. In one exemplary embodiment, the user database 41916 may include information for generating a user authenticity report and a wagering verification report. Further, the user database 41916 may be used to store user statistics like, but not limited to, the retention period for a particular user, frequency of wagers placed by a particular user, the average amount of wager placed by each user, etc.

Further, embodiments may include a historical plays database 41918 that may contain play data for the type of sport being played in the live event 41902. For example, in American Football, for optimal odds calculation, the historical play data may include metadata about the historical plays, such as time, location, weather, previous plays, opponent, physiological data, etc.

Further, embodiments may utilize an odds database 41920—that may contain the odds calculated by an odds calculation module 41922—to display the odds on the user's mobile device 41908 and take bets from the user through the mobile device wagering app 41910.

Further, embodiments may include the odds calculation module 41922, which may utilize historical play data to calculate odds for in-play wagers.

Further, embodiments may include a swipe input module 41924, which may display current wager options to the user within the wagering app 41910 and allow the user to place wagers by swiping across the screen of the mobile device 41908. Swipes may be made with a finger or any other object from which the mobile device 41908 can register a swipe. Examples of swipe inputs may include, swiping left to accept a wager option or swiping right to move to the next option. Different swipes may allow for more complex inputs. For example, longer swipes may increase the bet amount. In another embodiment, the user may swipe in the direction they think a player will run or a ball will go. Further, the user may be shown a picture of the game and may swipe over or around a player they wish to wager on, etc.,

Further, embodiments may include a gesture database 41926, which could also be considered as a swipe database in some embodiments, containing the commands that each different swipe represents. For example, a swipe left may be the command to place a wager, and a looped swipe may be the command to parlay one wager with another,

FIG. 420 illustrates the gesture wager module 41924, which could also be considered as a swipe wager module in some embodiments. The process may begin with the gesture wager module 41924 polling, at step 42000, for new wager options and odds in the odds database 41920. These may be the wager options and odds for the upcoming play of the live event 141902. The gesture wager module 41924 may display, at step 42002, the first wager option and the associated odds to the user. The option may be sent to the mobile device 41908 to be displayed via the wagering app 41910. The gesture wager module 41924 may poll, at step 42004, for a gesture or swipe input from the user device 41908. If the mobile device 41908 is not a touch screen device, the mobile app 41910 may detect this and relay this information to the wagering network 41914 such that a non-touch-based wagering module may be initiated. The gesture wager module 41924 may compare, at step 42006, the received swipe input to the swipe files in the gesture database 41926. This comparison may be made using an algorithm that compares the touch input to the swipe file and determines if the two are close enough to be considered similar. Similar may mean that the data of each show a similar pattern. For example, if the swipe file is a leftward motion in a straight line, then any leftward swipe in a straight line may be considered similar. The input line may not be perfectly straight, but a threshold of error may be expected with a human user. The gesture wager module 41924 may determine, at step 42008, if the received input is similar enough to a swipe file for there to be a match. How similar the input needs to be might be determined by an administrator of the system or another module. If there is no match, the gesture wager module 41924 may return, at step 42010, to step 42004. The gesture wager module 41924 may execute, at step 42012, the associated command in the swipe or gesture database 41926. The associated command may itself interact with the gesture wager module 41924. For example, the command may cause the gesture wager module 41924 to display the second wager option to the user via the user device and return to step 42004. The gesture wager module 41924 may determine, at step 42014, if the associated command was a command terminating the gesture wager module. For example, a two-finger pinch may be a command that would exit the gesture wager module 41924. Note that when implemented in computer code, the gesture wager module 41924 may not determine anything at this step; instead, the executed command may cause the gesture wager module 41924 to proceed or terminate. If the command was not terminal, the gesture wager module 41924 might return, at step 42016, to step 42004. The gesture wager module 41924 may alternatively follow the instructions of the executed command if they differ. If the command was terminal, the gesture wager module 41924 might return, at step 42018, to step 42000.

FIG. 421 illustrates the gesture database 41926, which may also be known as a swipe database in some embodiments. The gesture database 41926 may contain a set of commands and associated swipes or gestures that activate those commands. The commands in the figure are in English but maybe computer code commands based on the computer system and language of the wagering network 41914. The swipe or gesture may be stored as a file. When touch screen input is received, it may be compared to the file to determine if the input matches the file closely enough to be registered as that swipe or gesture. The file in the figure is a touch file, but may be other file extensions such as BMP, PCX, PCD, JPG, TIFF, GIF, IFF, IDC, or any other file type that could be used to recognize a touch screen input. The gestures on file may be related to many types of bets on a variety of wagering markets. For example, a user may point to a portion of home plate to wager that the next pitch would be a strike in a baseball game. The user may drag their finger along a representation of an American football field to indicate the direction and length of a pass or run. The user may swipe up and down across their display to change which wagering market they view and left and right to select the wagering option on that market. The user may change the number of fingers they make a gesture with to change the magnitude of the wager. The gesture may include the motion of the mobile device. In one embodiment, the accelerometers in the mobile device 41908 may allow the user to move their mobile device 41908 in one direction or another as an alternative to on-screen gestures. The motion of the mobile device 41908 may be used in conjunction with on-screen gestures. For example, the user may swipe left and right on their smartwatch to select a market and then make a bat swinging motion with their hand to select a wager on a hit. Haptic feedback may be used to confirm to the user that their gesture input has been received. For example, the sound and feel of a ball hitting a bat may be recreated on the mobile device 41908 to indicate the hit wager was received.

FIG. 422 illustrates a system for using an integrated sports wagering system, according to an embodiment.

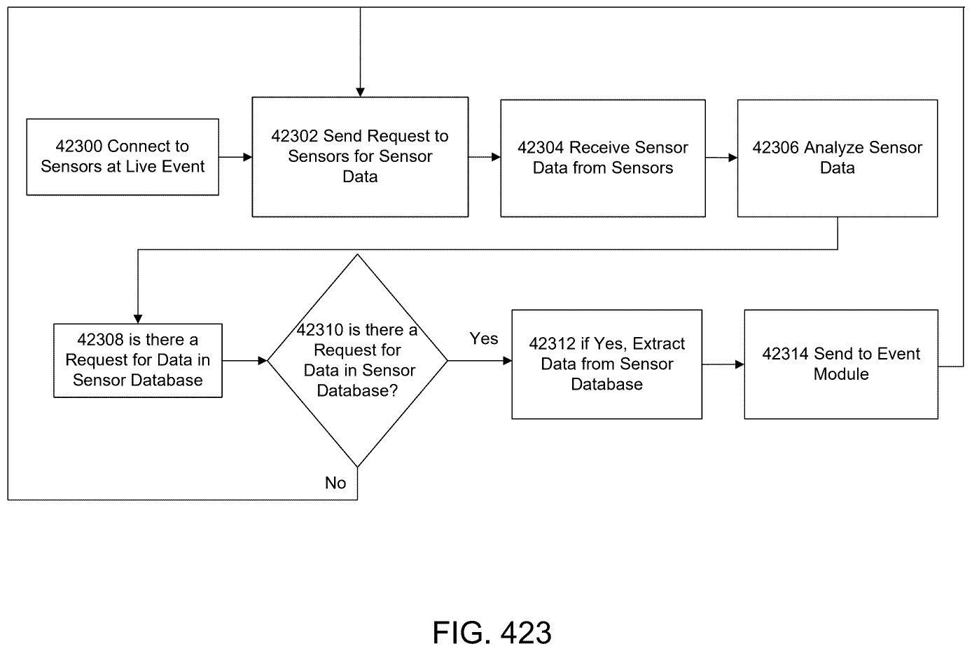

FIG. 423 illustrates a sensor data module, according to an embodiment.

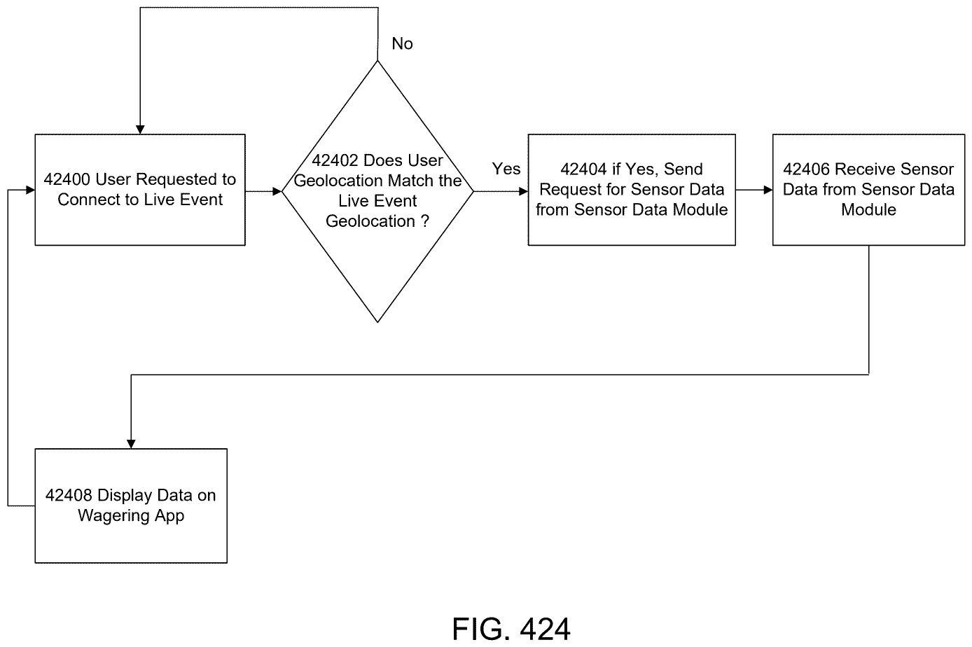

FIG. 424 illustrates an event data module according to an embodiment.

FIG. 422 is a system for using an integrated sports wagering system. This system may include a live event 42202, for example, a sporting event such as a football, basketball, baseball, or hockey game, tennis match, golf tournament, eSports, or digital game, etc. The live event 42202 may include some number of actions or plays upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 42202, such as the score of an American football game or the run line in a baseball game, or a series of actions in the live event 42202. Sportsbooks have several bets they can handle, limiting the number of wagers they can take on either side of a bet before moving the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers, which can be done at kiosks at the live event 42202 or at another location.

Further, embodiments may include a plurality of sensors 42204 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 42204 may include but are not limited to, tracking devices, such as RFID tags, GPS chips, or other such devices embedded on uniforms, in equipment, in the field of play and boundaries of the field of play, or on other markers in the field of play. In addition, imaging devices may also be used as tracking devices, such as player tracking, which provide statistical information through real-time X, Y positioning of players and X, Y, Z positioning of the ball.

Further, embodiments may include a sensor data module 42206, which may begin with the sensor data module 42206 connecting to the sensors 42204 at the live event 42202. For example, the sensor data module 42206 may connect to the various sensors 42204 located at the live event 42202, such as cameras, on-field sensors, player sensors, etc. Then the sensor data module 42206 may send a request to sensors 42204 for the sensor data. For example, the sensor data module 42206 may send a request for the data from the cameras, on-field sensors, player sensors, etc. The sensor data module 42206 may receive the sensor data from the sensors 42204. For example, the sensor data module 42206 may receive the data from the cameras, on-field sensors, player sensors, etc. Then the sensor data module 42206 may analyze the sensor data. For example, the analysis may include how many players are on the field, which players are on the field, how the players are positioned, etc. For example, the sensor data from a camera at a baseball event may be able to detect nine defensive players on the field, and of those nine players, there are seven players in a shift, such as the infielders and outfielders shifted more to the left side of the field than what is typically expected. The analysis may determine that since a left-handed hitter is up to bat, the defensive players are positioned in a defensive shift to prevent the hitter from getting on base. The sensor data module 42206 may store the analyzed sensor data in a sensor database 42208. For example, the data stored may be a left-handed hitter for the current at-bat, such as Rafael Devers of the Boston Red Sox, and the defense for the New York Yankees has shifted towards the left side of the field. It is then determined if there is a request for the data stored in the sensor database 42208 from the event data module 42220. If there is no request from the event data module 42220, then the process may return to sending a request to the sensors 42204 for the sensor data. If there is a request for the sensor data from the event data module 42220, the sensor data module 42206 may extract the sensor data from the sensor database 42208. For example, the data that may be sent to the event data module 42220 is that for the current at-bat, there is a left-handed hitter up, such as Rafael Devers of the Boston Red Sox, and the defense for the New York Yankees has shifted towards the left side of the field. Then the sensor data module 42206 may send the extracted sensor data from the sensor database 42208 to the event data module 42220, and the process may return to sending a request to the sensors 42204 for the sensor data.

Further, embodiments may include the sensor database 42208, which may contain analyzed sensor data from the various sensors 42204 located at a live event 42202, such as specific defensive positions in baseball, such as defensive shifts in real-time, specific defensive positions in basketball, such as a 2-3 zone, 1-3-1 zone, etc., defensive positions in football, such as a single high safety coverage, single-high safety coverage on one side of the field, no safety coverage on one side of the field, etc. The user may use this information to help or assist make play-by-play wagers on the upcoming play. For example, if a user is at the live event 42202 of the Boston Red Sox vs. the New York Yankees, and in the top of the first inning Rafael Devers is up to bat and the defensive position of the New York Yankees outfield and infield shifts to the right. The defensive position of each defensive player may appear on the wagering app 42214 to provide additional information that the user would not typically receive to make a more informed wager selection. For example, if the user is aware of the defensive shift, then the chances of Rafael Devers hitting a single decreases, while his chances of hitting a double, triple, or home run, etc., remain relatively the same. In some embodiments, the event data module 42220 may display the decrease in the possibility of a wager outcome occurring depending on a defensive or offensive shift. For example, if a user is at the live event 42202 of the Boston Red Sox vs. the New York Yankees, and in the top of the first inning Rafael Devers is up to bat and the defensive position of the New York Yankees outfield and infield shifts to the right then the wagering app 42214 may use data from the historical plays database 42226 located on the wagering network 42222 to determine the decrease in the percentage of Rafael Devers hitting a single, such as a 10% decrease in the outcome being a single compared to if there was no defensive shift. In some embodiments, the analyzed sensor data may include an increase or decrease in a player's speed during an event, such as running, skating, walking, etc., an increase or decrease in a player's throwing velocity, such as a pitcher in baseball, quarterback in football, etc. In some embodiments, the analyzed sensor data may include a player substitution during an event. In some embodiments, the analyzed sensor data may include a potential injury for a player, for example if a player's performance, such as running speed, throwing velocity, etc. decrease by a predetermined amount then it may be determined that a player has suffered an injury. In some embodiments, the analyzed sensor data may include a clutch factor or how a player is responding to a pressure situation within an event by measuring the player's heart rate prior to being involved to a play and measuring the player's heart rate during a play. For example, measuring a baseball player's heart rate when they are on-deck or next up to bat versus the player's heart rate when they are up to bat. In some embodiments, the analyzed sensor data may incorporate the player's statistics and update the player's statistics in real-time during the event. For example, updating a baseball player's batting average, number of at-bats, on-base percentage, runs scored, hits, singles, doubles, triples, home runs, steals, strikeouts, flyouts, groundouts, runs batted in (RBI), slugging percentage, walks, intentional walks, hit by pitches, etc. In some embodiments, the player's statistics may be updated in real-time for other sports in a similar manner, such as basketball, hockey, football, soccer, golf, tennis, Olympic sports, etc.

Further, embodiments may include a cloud 42210 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 42210 may be communicatively coupled to a wagering network 42222, which may perform real-time analysis on the type of play and the result of the play. The cloud 42210 may also be synchronized with game situational data such as the time of the game, the score, location on the field, weather conditions, and the like, which may affect the choice of play utilized. For example, in an exemplary embodiment, the cloud 42210 may not receive data gathered from the sensors 42204 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 42212 such as a computing device, laptop, smartphone, tablet, computer, smart speaker, or I/O devices. I/O devices may be present in the computing device. Input devices may include but are not limited to keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide-semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include but are not limited to video displays, graphical displays, speakers, headphones, inkjet printers, laser printers, or 3D printers. Devices may include but are not limited to a combination of multiple input or output devices such as Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs, including, but not limited to, Microsoft KINECT, SIRI for iPhone by Apple, Google Now, or Google Voice Search. Additional user devices have both input and output capabilities, including, but not limited to, haptic feedback devices, touchscreen displays, or multi-touch displays. Touchscreen, multi-touch displays, touchpads, touch mice, or other touch sensing devices may use different technologies to sense touch, including but not limited to capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 42212 could be an optional component and would be utilized in a situation where a paired wearable device employs the mobile device 42212 for additional memory or computing power or connection to the internet.

Further, embodiments may include a wagering software application or a wagering app 42214, which is a program that enables the user to place bets on individual plays in the live event 42202, streams audio and video from the live event 42202, and features the available wagers from the live event 42202 on the mobile device 42212. The wagering app 42214 allows users to interact with the wagering network 42222 to place bets and provide payment/receive funds based on wager outcomes.

Further, embodiments may include a GUI 42216 which may be used to display the analytics from the analyzed sensor data stored in the sensor database. The interface(s) may either accept inputs from users or provide outputs to the users, or may perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a Graphical User Interface (GUI), a voice interface, or a web-based user-interface.

Further, embodiments may include a mobile device database 42218 that may store some or all the user's data, the live event 42202, or the user's interaction with the wagering network 42222.

Further, embodiments may include an event data module 42220, which may begin with the user requesting to connect to the live event 42202. For example, a user may be present at a live event and may have the option or ability to connect to the live event 42202 or a network or server located at the live event 42202 to receive data that is unique to the live event that does not get passed on to the wagering network 42222, such as specific defensive positions in baseball, such as defensive shifts in real-time, specific defensive positions in basketball, such as a 2-3 zone, 1-3-1 zone, etc., defensive positions in football, such as a single high safety coverage, single-high safety coverage on one side of the field, no safety coverage on one side of the field, etc. The user may be able to use this information to help or assist make play-by-play wagers on the upcoming play. Then it may be determined if the user's geolocation matches the geolocation of the live event 42202. If there is no match between the user's geolocation and the live event 42202 geolocation, the process may return to the user requesting to connect to the live event 42202. In some embodiments, the user may receive a notification that they are not at the event and cannot connect to the live event 42202. In some embodiments, the user's geolocation position may be sent to the live event 42202, and if there is a match, the live event 42202 may send approval of sending the sensor data; however, if there is no match, then the live event 42202 may deny access to the sensor data. If there is a match between the user's geolocation and the live event geolocation, the event data module 42220 may send a request for the sensor data stored in the sensor database 42208 from the sensor data module 42206. For example, the event data module 42220 may send a request for data stored in the sensor database 42208, such as specific defensive positions in baseball, such as defensive shifts in real-time, specific defensive positions in basketball, such as a 2-3 zone, 1-3-1 zone, etc., defensive positions in football, such as a single high safety coverage, single-high safety coverage on one side of the field, no safety coverage on one side of the field, etc. The user may use this information to help or assist make play-by-play wagers on the upcoming play. Then the event data module 42220 may receive the sensor data stored in the sensor database 42208 from the sensor data module 42206. For example, the event data module 42220 may receive the data stored in the sensor database 42208, such as specific defensive positions in baseball, such as defensive shifts in real-time, specific defensive positions in basketball, such as a 2-3 zone, 1-3-1 zone, etc., defensive positions in football, such as a single high safety coverage, single-high safety coverage on one side of the field, no safety coverage on one side of the field, etc. The user may use this information to help or assist make play-by-play wagers on the upcoming play. The event data module 42220 may display the sensor data on the wagering app 42214, and the process may return to the user requesting to connect to the live event 42202. In some embodiments, the event data module 42220 may continuously receive the sensor data from the sensor data module 42206 as it is updated in real-time to continuously display the most up-to-date information from the sensors 42204 located at the live event 42202. For example, if a user is at the live event 42202 of the Boston Red Sox vs. the New York Yankees, and in the top of the first inning Rafael Devers is up to bat and the defensive position of the New York Yankees outfield and infield shifts to the right. The defensive position of each defensive player may appear on the wagering app 42214 to provide additional information that the user would not typically receive to make a more informed wager selection. For example, if the user is aware of the defensive shift, then the chances of Rafael Devers hitting a single decreases, while his chances of hitting a double, triple, or home run, etc., remain relatively the same. In some embodiments, the event data module 42220 may display the decrease in the possibility of a wager outcome occurring depending on a defensive or offensive shift. For example, if a user is at the live event 42202 of the Boston Red Sox vs. the New York Yankees, and in the top of the first inning Rafael Devers is up to bat and the defensive position of the New York Yankees outfield and infield shifts to the right then the wagering app 42214 may use data from the historical plays database 42226 located on the wagering network 42222 to determine the decrease in the percentage of Rafael Devers hitting a single, such as a 10% decrease in the outcome being a single compared to if there was no defensive shift.

Further, embodiments may include the wagering network 42222, which may perform real-time analysis on the type of play and the result of a play or action. The wagering network 42222 (or the cloud 42210) may also be synchronized with game situational data, such as the time of the game, the score, location on the field, weather conditions, and the like, which may affect the choice of play utilized. For example, in an exemplary embodiment, the wagering network 42222 may not receive data gathered from the sensors 42204 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 42222 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 42224, which may contain data relevant to all users of the wagering network 42222 and may include, but is not limited to, a user ID, a device identifier, a paired device identifier, wagering history, or wallet information for the user. The user database 42224 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 42224 may contain betting lines and search queries. The user database 42224 may be searched based on a search criterion received from the user. Each betting line may include, but is not limited to, a plurality of betting attributes such as at least one of the live event 42202, a team, a player, an amount of wager, etc. The user database 42224 may include but is not limited to information related to all the users involved in the live event 42202. In one exemplary embodiment, the user database 42224 may include information for generating a user authenticity report and a wagering verification report. Further, the user database 42224 may be used to store user statistics like, but not limited to, the retention period for a particular user, frequency of wagers placed by a particular user, the average amount of wager placed by each user, etc.

Further, embodiments may include a historical plays database 42226 that may contain play data for the type of sport being played in the live event 42202. For example, in American Football, for optimal odds calculation, the historical play data may include metadata about the historical plays, such as time, location, weather, previous plays, opponent, physiological data, etc.

Further, embodiments may utilize an odds database 42228—that may contain the odds calculated by an odds calculation module 42230—to display the odds on the user's mobile device 42212 and take bets from the user through the mobile device wagering app 42214.

Further, embodiments may include the odds calculation module 42230, which may utilize historical play data to calculate odds for in-play wagers.

FIG. 423 illustrates the sensor data module 42206. The process may begin with the sensor data module 42206 connecting, at step 42300, to the sensors 42204 at the live event 42202. For example, the sensor data module 42206 may connect to the various sensors 42204 located at the live event 42202, such as cameras, on-field sensors, player sensors, etc. Then the sensor data module 42206 may send, at step 42302, a request to the sensors 42204 for the sensor data. For example, the sensor data module 42206 may send a request for the data from the cameras, on-field sensors, player sensors, etc. The sensor data module 42206 may receive, at step 42304, the sensor data from the sensors 42204. For example, the sensor data module 42206 may receive the data from the cameras, on-field sensors, player sensors, etc. Then the sensor data module 42206 may analyze, at step 42306, the sensor data. For example, the analysis may include how many players are on the field, which players are on the field, how the players are positioned, etc. For example, the sensor data from a camera at a baseball event may be able to detect nine defensive players on the field, and of those nine players, there are seven players in a shift, such as the infielders and outfielders shifted more to the left side of the field than what is typically expected. The analysis may determine that since a left-handed hitter is up to bat, the defensive players are positioned in a defensive shift to prevent the hitter from getting on base. In some embodiments, the analyzed sensor data may include an increase or decrease in a player's speed during an event, such as running, skating, walking, etc., an increase or decrease in a player's throwing velocity, such as a pitcher in baseball, quarterback in football, etc. In some embodiments, the analyzed sensor data may include a player substitution during an event. In some embodiments, the analyzed sensor data may include a potential injury for a player, for example if a player's performance, such as running speed, throwing velocity, etc. decrease by a predetermined amount then it may be determined that a player has suffered an injury. In some embodiments, the analyzed sensor data may include a clutch factor or how a player is responding to a pressure situation within an event by measuring the player's heart rate prior to being involved to a play and measuring the player's heart rate during a play. For example, measuring a baseball player's heart rate when they are on-deck or next up to bat versus the player's heart rate when they are up to bat. In some embodiments, the analyzed sensor data may incorporate the player's statistics and update the player's statistics in real-time during the event. For example, updating a baseball player's batting average, number of at-bats, on-base percentage, runs scored, hits, singles, doubles, triples, home runs, steals, strikeouts, flyouts, groundouts, runs batted in (RBI), slugging percentage, walks, intentional walks, hit by pitches, etc. In some embodiments, the player's statistics may be updated in real-time for other sports in a similar manner, such as basketball, hockey, football, soccer, golf, tennis, Olympic sports, etc. The sensor data module 42206 may store, at step 42308, the analyzed sensor data in the sensor database 42208. For example, the data stored may be that there is a left-handed hitter for the current at-bat, such as Rafael Devers of the Boston Red Sox, and the defense for the New York Yankees has shifted towards the left side of the field. In some embodiments, the analyzed sensor data may include an increase or decrease in a player's speed during an event, such as running, skating, walking, etc., an increase or decrease in a player's throwing velocity, such as a pitcher in baseball, quarterback in football, etc. In some embodiments, the analyzed sensor data may include a player substitution during an event. In some embodiments, the analyzed sensor data may include a potential injury for a player, for example if a player's performance, such as running speed, throwing velocity, etc. decrease by a predetermined amount then it may be determined that a player has suffered an injury. In some embodiments, the analyzed sensor data may include a clutch factor or how a player is responding to a pressure situation within an event by measuring the player's heart rate prior to being involved to a play and measuring the player's heart rate during a play. For example, measuring a baseball player's heart rate when they are on-deck or next up to bat versus the player's heart rate when they are up to bat. In some embodiments, the analyzed sensor data may incorporate the player's statistics and update the player's statistics in real-time during the event. For example, updating a baseball player's batting average, number of at-bats, on-base percentage, runs scored, hits, singles, doubles, triples, home runs, steals, strikeouts, flyouts, groundouts, runs batted in (RBI), slugging percentage, walks, intentional walks, hit by pitches, etc. In some embodiments, the player's statistics may be updated in real-time for other sports in a similar manner, such as basketball, hockey, football, soccer, golf, tennis, Olympic sports, etc. The sensor data module 42206 may determine, at step 42310, if there is a request for the data stored in the sensor database 42208 from the event data module 42220. If there is no request from the event data module 42220, then the process may return to sending a request to the sensors 42204 for the sensor data. In some embodiments, the user may purchase a subscription for the access to the analyzed sensor data stored in the sensor database 42208. For example, the user may purchase the subscription prior to an event or during the event through the wagering app 42214 from the wagering network 42222 and the wagering network 42222 may provide the user's user ID to the live event, and when providing the analyzed sensor data to the mobile device 42212 the sensor data module 42206 may verify the user's geolocation and determine if the wagering network 42222 has sent the user ID to verify that the user purchased a subscription to the analyzed sensor stored in the sensor database 42208. If there is a request for the sensor data from the event data module 42220, the sensor data module 42206 may extract, at step 42312, the sensor data from the sensor database 42208. For example, the data that may be sent to the event data module 42220 is that for the current at-bat, there is a left-handed hitter up, such as Rafael Devers of the Boston Red Sox, and the defense for the New York Yankees has shifted towards the left side of the field. Then the sensor data module 42206 may send, at step 42314, the extracted sensor data from the sensor database 42208 to the event data module 42220, and the process may return to sending a request to the sensors 42204 for the sensor data at step 42302.

FIG. 424 illustrates the event data module 42220. The process may begin with the user requesting, at step 42400, to connect to the live event 42202. For example, a user may be present at a live event and may have the option or ability to connect to the live event 42202 or a network or server located at the live event 42202 to receive data that is unique to the live event that does not get passed on to the wagering network 42222, such as specific defensive positions in baseball, such as defensive shifts in real-time, specific defensive positions in basketball, such as a 2-3 zone, 1-3-1 zone, etc., defensive positions in football, such as a single high safety coverage, single-high safety coverage on one side of the field, no safety coverage on one side of the field, etc. The user may use this information to help or assist make play-by-play wagers on the upcoming play. In some embodiments, the user may purchase a subscription for the access to the analyzed sensor data stored in the sensor database 42208. For example, the user may purchase the subscription prior to an event or during the event through the wagering app 42214 from the wagering network 42222 and the wagering network may provide the user's user ID to the live event, and when providing the analyzed sensor data to the mobile device 42212 the sensor data module 42206 may verify the user's geolocation and determine if the wagering network 42222 has sent the user ID to verify that the user purchased a subscription to the analyzed sensor stored in the sensor database 42208. The event data module 42220 may determined, at step 42402, if the user's geolocation matches the geolocation of the live event 42202. If there is no match between the user's geolocation and the live event 42202 geolocation, the process may return to the user requesting to connect to the live event 42202. In some embodiments, the user may receive a notification that they are not at the event and cannot connect to the live event 42202. In some embodiments, the user's geolocation position may be sent to the live event 42202, and if there is a match, the live event 42202 may send approval of sending the sensor data; however, if there is no match, then the live event 42202 may deny access to the sensor data. If there is a match between the user's geolocation and the live event geolocation, the event data module 42220 may send, at step 42404, a request for the sensor data stored in the sensor database 42208 from the sensor data module 42206. For example, the event data module 42220 may send a request for data stored in the sensor database 42208, such as specific defensive positions in baseball, such as defensive shifts in real-time, specific defensive positions in basketball, such as a 2-3 zone, 1-3-1 zone, etc., defensive positions in football, such as a single high safety coverage, single-high safety coverage on one side of the field, no safety coverage on one side of the field, etc. The user may use this information to help or assist make play-by-play wagers on the upcoming play. Then the event data module 42220 may receive, at step 42406, the sensor data stored in the sensor database 42208 from the sensor data module 42206. For example, the event data module 42220 may receive the data stored in the sensor database 42208, such as specific defensive positions in baseball, such as defensive shifts in real-time, specific defensive positions in basketball, such as a 2-3 zone, 1-3-1 zone, etc., defensive positions in football, such as a single high safety coverage, single-high safety coverage on one side of the field, no safety coverage on one side of the field, etc. The user may use this information to help or assist make play-by-play wagers on the upcoming play. In some embodiments, the analyzed sensor data may include an increase or decrease in a player's speed during an event, such as running, skating, walking, etc., an increase or decrease in a player's throwing velocity, such as a pitcher in baseball, quarterback in football, etc. In some embodiments, the analyzed sensor data may include a player substitution during an event. In some embodiments, the analyzed sensor data may include a potential injury for a player, for example if a player's performance, such as running speed, throwing velocity, etc. decrease by a predetermined amount then it may be determined that a player has suffered an injury. In some embodiments, the analyzed sensor data may include a clutch factor or how a player is responding to a pressure situation within an event by measuring the player's heart rate prior to being involved to a play and measuring the player's heart rate during a play. For example, measuring a baseball player's heart rate when they are on-deck or next up to bat versus the player's heart rate when they are up to bat. In some embodiments, the analyzed sensor data may incorporate the player's statistics and update the player's statistics in real-time during the event. For example, updating a baseball player's batting average, number of at-bats, on-base percentage, runs scored, hits, singles, doubles, triples, home runs, steals, strikeouts, flyouts, groundouts, runs batted in (RBI), slugging percentage, walks, intentional walks, hit by pitches, etc. In some embodiments, the player's statistics may be updated in real-time for other sports in a similar manner, such as basketball, hockey, football, soccer, golf, tennis, Olympic sports, etc. The event data module 42220 may display, at step 42408, the sensor data on the wagering app 42214 or on the GUI 42216, and the process may return to the user requesting to connect to the live event 42202 at step 42400. In some embodiments, the event data module 42220 may continuously receive the sensor data from the sensor data module 42206 as it is updated in real-time to continuously display the most up-to-date information from the sensors 42204 located at the live event 42202. For example, if a user is at the live event 42202 of the Boston Red Sox vs. the New York Yankees, and in the top of the first inning Rafael Devers is up to bat and the defensive position of the New York Yankees outfield and infield shifts to the right. The defensive position of each defensive player may appear on the wagering app 42214 to provide additional information that the user would not typically receive to make a more informed wager selection. For example, if the user is aware of the defensive shift, then the chances of Rafael Devers hitting a single decreases, while his chances of hitting a double, triple, or home run, etc., remain relatively the same. In some embodiments, the event data module 42220 may display the decrease in the possibility of a wager outcome occurring depending on a defensive or offensive shift. For example, if a user is at the live event 42202 of the Boston Red Sox vs. the New York Yankees, and in the top of the first inning Rafael Devers is up to bat and the defensive position of the New York Yankees outfield and infield shifts to the right then the wagering app 42214 may use data from the historical plays database 42226 located on the wagering network 42222 to determine the decrease in the percentage of Rafael Devers hitting a single, such as a 10% decrease in the outcome being a single compared to if there was no defensive shift.

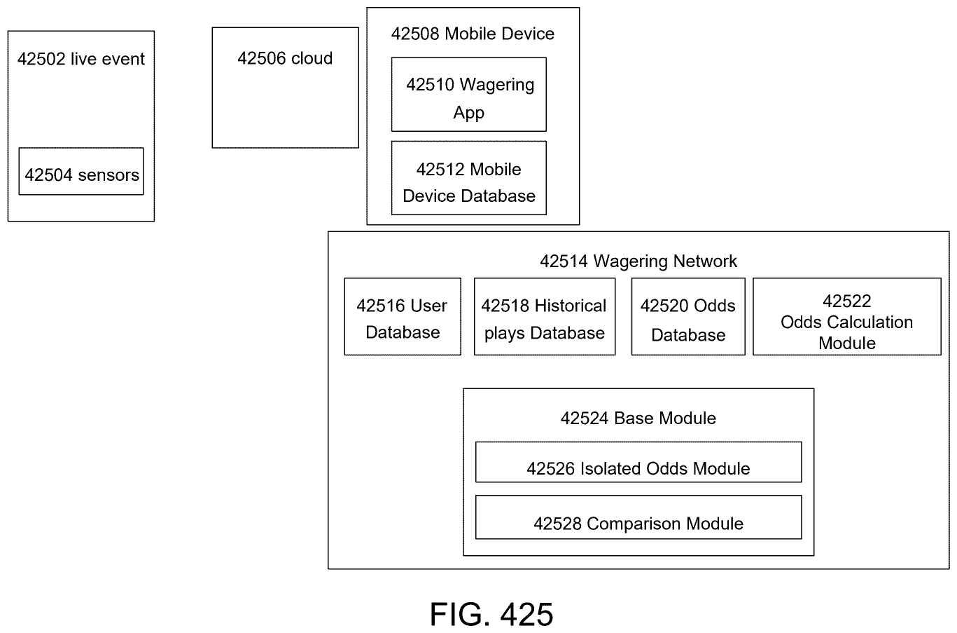

FIG. 425 illustrates a system for providing wagering odds without the results of a first play, according to an embodiment.

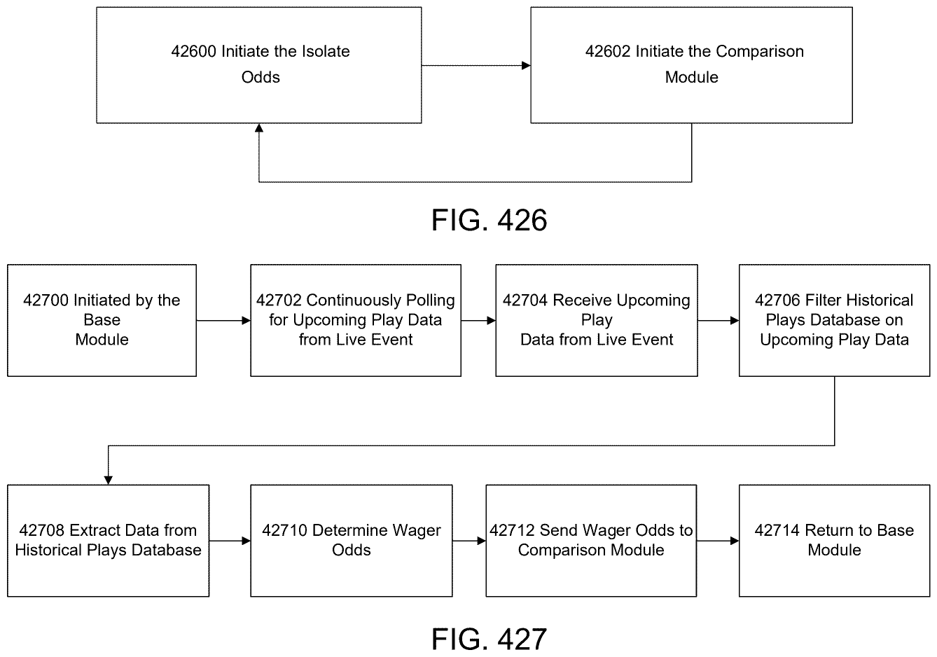

FIG. 426 illustrates a base module, according to an embodiment.

FIG. 427 illustrates an isolated odds module, according to an embodiment.

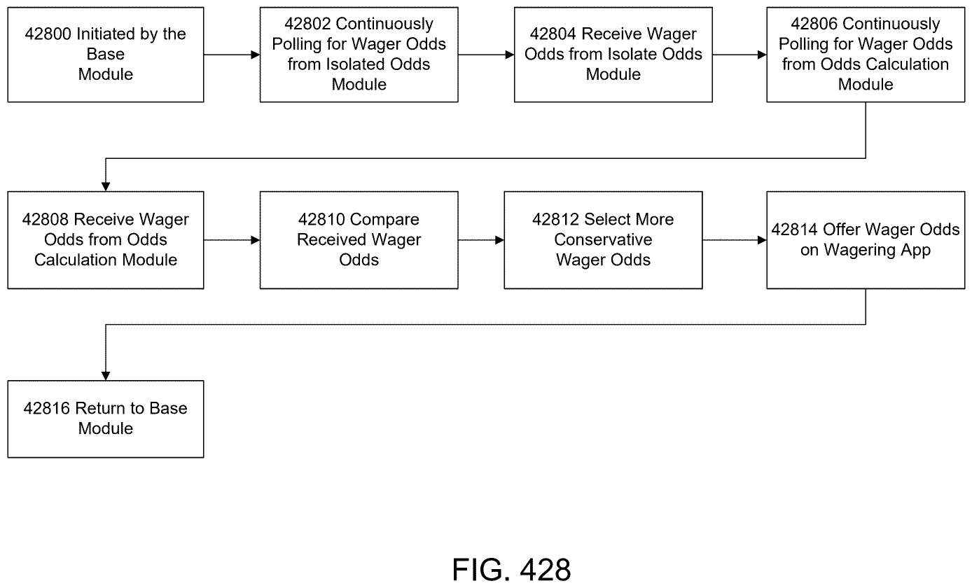

FIG. 428 illustrates a comparison module, according to an embodiment.

FIG. 425 is a system for providing wagering odds without the results of a first play. This system may include a live event 42502, for example, a sporting event such as a football, basketball, baseball, or hockey game, tennis match, golf tournament, eSports or digital game, etc. The live event 42502 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 42502, such as the score of an American football game or the run line in a baseball game, or a series of actions in the live event 42502. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 42502 or at another location. Further, embodiments may include a plurality of sensors 42504 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 42504 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Fu Further, embodiments may include a cloud 42506 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 42506 may be communicatively coupled to a peer-to-peer wagering network 42514, which may perform real-time analysis on the type of play and the result of the play. The cloud 42506 may also be synchronized with game situational data such as the time of the game, the score, location on the field, weather conditions, and the like, which may affect the choice of play utilized. For example, in an exemplary embodiment, the cloud 42506 may not receive data gathered from the sensors 42504 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 42508 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 42508 could be an optional component and would be utilized in a situation where a paired wearable device employs the mobile device 42508 for additional memory or computing power or connection to the internet.

Further, embodiments may include a wagering software application or a wagering app 42510, which is a program that enables the user to place bets on individual plays in the live event 42502, streams audio and video from the live event 42502, and features the available wagers from the live event 42502 on the mobile device 42508. The wagering app 42510 allows the user to interact with the wagering network 42514 to place bets and provide payment/receive funds based on wager outcomes.

Further, embodiments may include a mobile device database 42512 that may store some or all the user's data, the live event 42502, or the user's interaction with the wagering network 42514.

Further, embodiments may include the wagering network 42514, which may perform real-time analysis on the type of play and the result of a play or action. The wagering network 42514 (or the cloud 42506) may also be synchronized with game situational data, such as the time of the game, the score, location on the field, weather conditions, and the like, which may affect the choice of play utilized. For example, in an exemplary embodiment, the wagering network 42514 may not receive data gathered from the sensors 42504 and may, instead, receive data from an alternative data feed, such as SportsRadar®. This data may be provided substantially immediately following the completion of any play, and may be compared with a variety of team data and league data based on a variety of elements, including the current down, possession, score, time, team, and so forth, as described in various exemplary embodiments herein. The wagering network 42514 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 42516, which may contain data relevant to all users of the wagering network 42514 and may include, but is not limited to, a user ID, a device identifier, a paired device identifier, wagering history, or wallet information for the user. The user database 42516 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 42516 may contain betting lines and search queries. The user database 42516 may be searched based on a search criterion received from the user. Each betting line may include, but is not limited to, a plurality of betting attributes such as at least one of the live event 42502, a team, a player, an amount of wager, etc. The user database 42516 may include, but is not limited to, information related to all the users involved in the live event 42502. In one exemplary embodiment, the user database 42516 may include information for generating a user authenticity report and a wagering verification report. Further, the user database 42516 may be used to store user statistics like, but not limited to, the retention period for a particular user, frequency of wagers placed by a particular user, the average amount of wager placed by each user, etc.

Further, embodiments may include a historical plays database 42518 that may contain play data for the type of sport being played in the live event 42502. For example, in American Football, for optimal odds calculation, the historical play data may include metadata about the historical plays, such as time, location, weather, previous plays, opponent, physiological data, etc.

Further, embodiments may utilize an odds database 42520—that contains the odds calculated by an odds calculation module 42522—to display the odds on the user's mobile device 42508 and take bets from the user through the mobile device wagering app 42510.

Further, embodiments may include the odds calculation module 42522, which utilizes historical play data to calculate odds for in-play wagers.

Further, embodiments may include a base module 42524, which begins with the base module 42524 initiating an isolated odds module 42526 in which the isolated odds module 42526 is continuously polling for the upcoming play data from the live event 42502. Then the isolated odds module 42526 receives the upcoming play data from the live event 42502 and filters the historical plays database 42518 on the upcoming play data. Then the isolated odds module 42526 extracts the data from the historical plays database 42518 and determines the wager odds. Then the isolated odds module 42526 sends the wager odds to a comparison module 42528 and returns to the base module 42524. Then the base module 42524 initiates the comparison module 42528, in which the comparison module 42528 continuously polls for the wager odds from the isolated odds module 42526 and receives the wager odds from the isolated odds module 42526. The comparison module 42528 may continuously poll for the wager odds from the odds calculation module 42522 and receives the wager odds from the odds calculation module 42522. Then the comparison module 42528 compares the received wager odds and selects the more conservative wager odds. Finally, the comparison module 42528 offers the wager odds on the wagering app 42510 and returns to the base module 42524.

Further, embodiments may include the isolated odds module 42526, which begins with the base module 42524 initiating the isolated odds module 42526. For example, the base module 42524 may initiate the isolated odds module 42526 if the wagering network 42514 does not receive the results of the previous play. The isolated odds module 42526 may continuously poll for the upcoming play data from the live event 42502. The isolated odds module 42526 may continuously poll to receive the data from the live event 42502 that represents the current state of the live event 42502, such as that in a Boston Red Sox vs. New York Yankees game it is the top of the 5th inning, with one out and J. D. Martinez at-bat with no pitches being thrown yet. Then the isolated odds module 42526 receives the upcoming play data from the live event 42502. For example, the upcoming play data may be in the Boston Red Sox vs. New York Yankees game; it is the top of the 5th inning, with one out and J. D. Martinez at-bat with no pitches thrown yet. The isolated odds module 42526 filters the historical plays database 42518 on the upcoming play data. For example, the historical plays database 42518 is filtered for the Boston Red Sox vs. the New York Yankees, in top of the 5th inning, with one out and the batter being J. D. Martinez. Then the isolated odds module 42526 extracts the data from the historical plays database 42518. For example, the isolated odds module 42526 extracts all the historical wagering odds data associated with the event being the Boston Red Sox vs. New York Yankees game in the top of the 5th inning, with one out and J. D. Martinez at-bat with no pitches being thrown yet. The isolated odds module 42526 determines the wager odds. For example, the isolated odds module 42526 may determine the average wager odds from the historical wager odds extracted from the historical plays database 42518, such as if the historical wager odds for the Boston Red Sox's J. D. Martinez hitting a single in the top of the 5th inning with one out versus the New York Yankees were 2:1, 3:1, 4:1, 3:1, 3:1, and 3:1, then the determined wagering odds would be 3:1. In some embodiments, the isolated odds module 42526 determines the wagering odds for all potential outcomes for the upcoming play, such as for the hit to be a single, double, triple, home run, strikeout, flyout, groundout, or a called ball, or strike, or swinging strike. Then the isolated odds module 42526 sends the wager odds to the comparison module 42528. For example, the isolated odds module 42526 sends the odds that the Boston Red Sox's J. D. Martinez will hit a single in the top of the 5th inning with one out versus the New York Yankees is 3:1 to the comparison module 42528. The isolated odds module 42526 returns to the base module 42524.

Further, embodiments may include the comparison module 42528, which begins with the base module 42524 initiating the comparison module 42528. The comparison module 42528 may continuously poll for the wager odds from the isolated odds module 42526. For example, the comparison module 42528 may continuously poll for the wagering odds from the isolated odds module 42526, such as that the Boston Red Sox's J. D. Martinez hitting a single in the top of the 5th inning with one out versus the New York Yankees is 3:1. Then the comparison module 42528 receives the wager odds from the isolated odds module 42526. For example, the comparison module 42528 receives the wagering odds from the isolated odds module 42526, such as that the Boston Red Sox's J. D. Martinez hitting a single in the top of the 5th inning with one out versus the New York Yankees is 3:1. In some embodiments, the comparison module 42528 may receive the wagering odds for all potential outcomes for the upcoming play, such as for the hit to be a single, double, triple, home run, strikeout, flyout, groundout, or a called ball, or strike, or swinging strike. The comparison module 42528 may continuously poll for series wager odds from the odds calculation module 42522. For example, the comparison module 42528 may continuously poll for the series wagering odds from the odds calculation module 42522, such as that the Boston Red Sox's J. D. Martinez hitting a single in the top of the 5th inning with one out versus the New York Yankees is 4:1. The comparison module 42528 receives the series wager odds from the odds calculation module 42522. For example, the comparison module 42528 receives the series wagering odds from the odds calculation module 42522, such as that the Boston Red Sox's J. D. Martinez hitting a single in the top of the 5th inning with one out versus the New York Yankees is 4:1. Then the comparison module 42528 compares the received wager odds. For example, the comparison module 42528 compares the received wagering odds of the Boston Red Sox's J. D. Martinez hitting a single in the top of the 5th inning with one out versus the New York Yankees is 3:1 and 4:1, this comparison is to determine the wagering odds that would be the most conservative to the house or wagering network 42514, or for the wagering odds that would result in the lowest loss if the selected wager outcome, for example, a single is hit, occurs. In this example, the more conservative odds would be 3:1 since if the outcome occurs, the wagering network 42514 would pay out less to the users. Then the comparison module 42528 selects the more conservative wager odds. For example, the comparison module 42528 selects the wager odds of 3:1 for the Boston Red Sox's J. D. Martinez hitting a single in the top of the 5th inning with one out versus the New York Yankees. The comparison module 42528 offers the wager odds on the wagering app 42510. For example, the comparison module 42528 offers the wagering odds of 3:1 for the Boston Red Sox's J. D. Martinez hitting a single in the top of the 5th inning with one out versus the New York Yankees on the wagering app 42510 through the wagering network 42514. Then the comparison module 42528 returns to the base module 42524.

FIG. 426 illustrates the base module 42524. The process begins with the base module 42524 initiating, at step 42600, the isolated odds module 42526. For example, the isolated odds module 42526 begins with the base module 42524 initiating the isolated odds module 42526. For example, the base module 42524 may initiate the isolated odds module 42526 if the wagering network 42514 does not receive the results of the previous play. The isolated odds module 42526 may continuously poll for the upcoming play data from the live event 42502. For example, the isolated odds module 42526 may continuously poll to receive the data from the live event 42502 that represents the current state of the live event 42502, such as in the Boston Red Sox vs. New York Yankees game it is the top of the 5th inning, with one out and J. D. Martinez at-bat with no pitches being thrown yet. Then the isolated odds module 42526 receives the upcoming play data from the live event 42502. For example, the upcoming play data may be in the Boston Red Sox vs. New York Yankees game; it is the top of the 5th inning, with one out and J. D. Martinez at-bat with no pitches thrown yet. The isolated odds module 42526 filters the historical plays database 42518 on the upcoming play data. For example, the historical plays database 42518 is filtered for the Boston Red Sox vs. the New York Yankees, in top of the 5th inning, with one out and the batter being J. D. Martinez. Then the isolated odds module 42526 extracts the data from the historical plays database 42518. For example, the isolated odds module 42526 extracts all the historical wagering odds data associated with the event being the Boston Red Sox vs. New York Yankees game in the top of the 5th inning, with one out and J. D. Martinez at-bat with no pitches being thrown yet. The isolated odds module 42526 determines the wager odds. For example, the isolated odds module 42526 may determine the average wager odds from the odds of the historical wagers extracted from the historical plays database 42518, such as if the historical wager odds for the Boston Red Sox's J. D. Martinez hitting a single in the top of the 5th inning with one out versus the New York Yankees were 2:1, 3:1, 4:1, 3:1, 3:1, and 3:1, then the determined wagering odds would be 3:1. In some embodiments, the isolated odds module 42526 determines the wagering odds for all potential outcomes for the upcoming play, such as for the hit to be a single, double, triple, home run, strikeout, flyout, groundout, or a called ball, or strike, or swinging strike. Then the isolated odds module 42526 sends the wager odds to the comparison module 42528. For example, the isolated odds module 42526 sends the odds that the Boston Red Sox's J. D. Martinez will hit a single in the top of the 5th inning with one out versus the New York Yankees is 3:1 to the comparison module 42528. The isolated odds module 42526 returns to the base module 42524. Then the base module 42524 initiates, at step 42602, the comparison module 42528. The comparison module 42528 begins with the base module 42524 initiating the comparison module 42528. The comparison module 42528 may continuously poll for the wager odds from the isolated odds module 42526. For example, the comparison module 42528 may continuously poll for the wagering odds from the isolated odds module 42526, such as that the Boston Red Sox's J. D. Martinez hitting a single in the top of the 5th inning with one out versus the New York Yankees is 3:1. Then the comparison module 42528 receives the wager odds from the isolated odds module 42526. For example, the comparison module 42528 receives the wagering odds from the isolated odds module 42526, such as that the Boston Red Sox's J. D. Martinez hitting a single in the top of the 5th inning with one out versus the New York Yankees is 3:1. In some embodiments, the comparison module 42528 may receive the wagering odds for all potential outcomes for the upcoming play, such as for the hit to be a single, double, triple, home run, strikeout, flyout, groundout, or a called ball, or strike, or swinging strike. The comparison module 42528 may continuously poll for the series wager odds from the odds calculation module 42522. For example, the comparison module 42528 may continuously poll for the series wagering odds from the odds calculation module 42522, such as that the Boston Red Sox's J. D. Martinez hitting a single in the top of the 5th inning with one out versus the New York Yankees is 4:1. The comparison module 42528 receives the series wager odds from the odds calculation module 42522. For example, the comparison module 42528 receives the series wagering odds from the odds calculation module 42522, such as that the Boston Red Sox's J. D. Martinez hitting a single in the top of the 5th inning with one out versus the New York Yankees is 4:1. Then the comparison module 42528 compares the received wager odds. For example, the comparison module 42528 compares the received wagering odds of the Boston Red Sox's J. D. Martinez hitting a single in the top of the 5th inning with one out versus the New York Yankees is 3:1 and 4:1, this comparison is to determine the wagering odds that would be the most conservative to the house or wagering network 42514, or for the wagering odds that would result in the lowest loss if the selected wager outcome, for example, a single is hit, occurs. In this example, the more conservative odds would be 3:1 since if the outcome occurs, the wagering network 42514 would pay out less to the users. Then the comparison module 42528 selects the more conservative wager odds. For example, the comparison module 42528 selects the wager odds of 3:1 for the Boston Red Sox's J. D. Martinez hitting a single in the top of the 5th inning with one out versus the New York Yankees. The comparison module 42528 offers the wager odds on the wagering app 42510. For example, the comparison module 128 offers the wagering odds of 3:1 for the Boston Red Sox's J. D. Martinez hitting a single in the top of the 5th inning with one out versus the New York Yankees on the wagering app 42510 through the wagering network 42514. Then the comparison module 42528 returns to the base module 42524.

FIG. 427 illustrates the isolated odds module 42526. The process begins with the base module 42524 initiating, at step 42700, the isolated odds module 42526. For example, the base module 42524 may initiate the isolated odds module 42526 if the wagering network 42514 does not receive the results of the previous play. The isolated odds module 42526 may continuously poll, at step 42702, for the upcoming play data from the live event 42502. For example, the isolated odds module 42526 may continuously poll to receive the data from the live event 42502 that represents the current state of the live event 42502, such as in the Boston Red Sox vs. New York Yankees game it is the top of the 5th inning, with one out and J. D. Martinez at-bat with no pitches being thrown yet. Then the isolated odds module 42526 receives, at step 42704, the upcoming play data from the live event 42502. For example, the upcoming play data may be in the Boston Red Sox vs. New York Yankees game; it is the top of the 5th inning, with one out and J. D. Martinez at-bat with no pitches thrown yet. The isolated odds module 42526 filters, at step 42706, the historical plays database 42518 on the upcoming play data. For example, the historical plays database 42518 is filtered for the Boston Red Sox vs. the New York Yankees, in top of the 5th inning, with one out and the batter being J. D. Martinez. Then the isolated odds module 42526 extracts, at step 42708, the data from the historical plays database 42518. For example, the isolated odds module 42526 extracts all the historical wagering odds data associated with the event being the Boston Red Sox vs. New York Yankees game in the top of the 5th inning, with one out and J. D. Martinez at-bat with no pitches being thrown yet. The isolated odds module 42526 determines, at step 42710, the wager odds. For example, the isolated odds module 42526 may determine the average wager odds from the odds of the historical wagers extracted from the historical plays database 42518, such as if the historical wager odds for the Boston Red Sox's J. D. Martinez hitting a single in the top of the 5th inning with one out versus the New York Yankees were 2:1, 3:1, 4:1, 3:1, 3:1, and 3:1, then the determined wagering odds would be 3:1. In some embodiments, the isolated odds module 42526 determines the wagering odds for all potential outcomes for the upcoming play, such as for the hit to be a single, double, triple, home run, strikeout, flyout, groundout, or a called ball, or strike, or swinging strike. Then the isolated odds module 42526 sends, at step 42712, the wager odds to the comparison module 42528. For example, the isolated odds module 42526 sends the odds that the Boston Red Sox's J. D. Martinez will hit a single in the top of the 5th inning with one out versus the New York Yankees is 3:1 to the comparison module 42528. The isolated odds module 42526 returns, at step 42714, to the base module 42524.

FIG. 428 illustrates the comparison module 42528. The process begins with the base module 42524 initiating, at step 42800, the comparison module 42528. The comparison module 42528 may continuously poll, at step 42802, for the wager odds from the isolated odds module 42526. For example, the comparison module 42528 may continuously poll for the wagering odds from the isolated odds module 42526, such as that the Boston Red Sox's J. D. Martinez hitting a single in the top of the 5th inning with one out versus the New York Yankees is 3:1. Then the comparison module 42528 receives, at step 42804, the wager odds from the isolated odds module 42526. For example, the comparison module 42528 receives the wagering odds from the isolated odds module 42526, such as that the Boston Red Sox's J. D. Martinez hitting a single in the top of the 5th inning with one out versus the New York Yankees is 3:1. In some embodiments, the comparison module 42528 may receive the wagering odds for all potential outcomes for the upcoming play, such as for the hit to be a single, double, triple, home run, strikeout, flyout, groundout, or a called ball, or strike, or swinging strike. The comparison module 42528 may continuously poll, at step 42806, for the series wager odds from the odds calculation module 42522. For example, the comparison module 42528 may continuously poll for the series wagering odds from the odds calculation module 42522, such as that the Boston Red Sox's J. D. Martinez hitting a single in the top of the 5th inning with one out versus the New York Yankees is 4:1. The comparison module 42528 receives, at step 42808, the series wager odds from the odds calculation module 42522. For example, the comparison module 42528 receives the series wagering odds from the odds calculation module 42522, such as that the Boston Red Sox's J. D. Martinez hitting a single in the top of the 5th inning with one out versus the New York Yankees is 4:1. Then the comparison module 42528 compares, at step 42710, the received wager odds. For example, the comparison module 42528 compares the received wagering odds of the Boston Red Sox's J. D. Martinez hitting a single in the top of the 5th inning with one out versus the New York Yankees is 3:1 and 4:1, this comparison is to determine the wagering odds that would be the most conservative to the house or wagering network 42514, or for the wagering odds that would result in the lowest loss if the selected wager outcome, for example, a single is hit, occurs. In this example, the more conservative odds would be 3:1 since if the outcome occurs, the wagering network 42514 would pay out less to the users. Then the comparison module 42528 selects, at step 42812, the more conservative wager odds. For example, the comparison module 42528 selects the wager odds of 3:1 for the Boston Red Sox's J. D. Martinez hitting a single in the top of the 5th inning with one out versus the New York Yankees. The comparison module 42528 offers, at step 42814, the wager odds on the wagering app 42510. For example, the comparison module 42528 offers the wagering odds of 3:1 for the Boston Red Sox's J. D. Martinez hitting a single in the top of the 5th inning with one out versus the New York Yankees on the wagering app 42510 through the wagering network 42514. Then the comparison module 42528 returns, at step 42816, to the base module 42524.

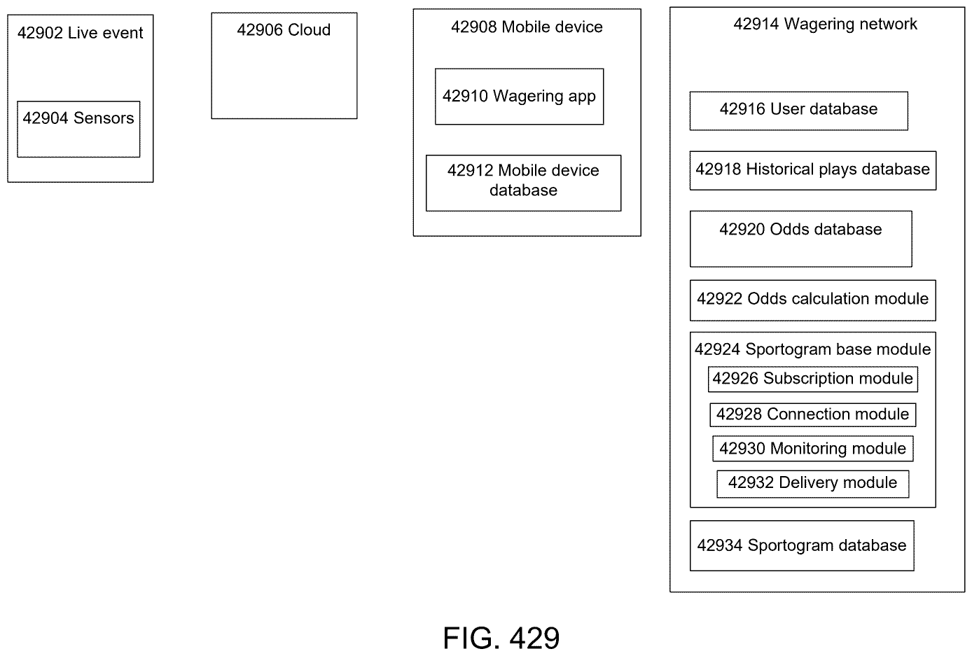

FIG. 429 illustrates a system for celebrating or taunting users of a wagering network, according to an embodiment.

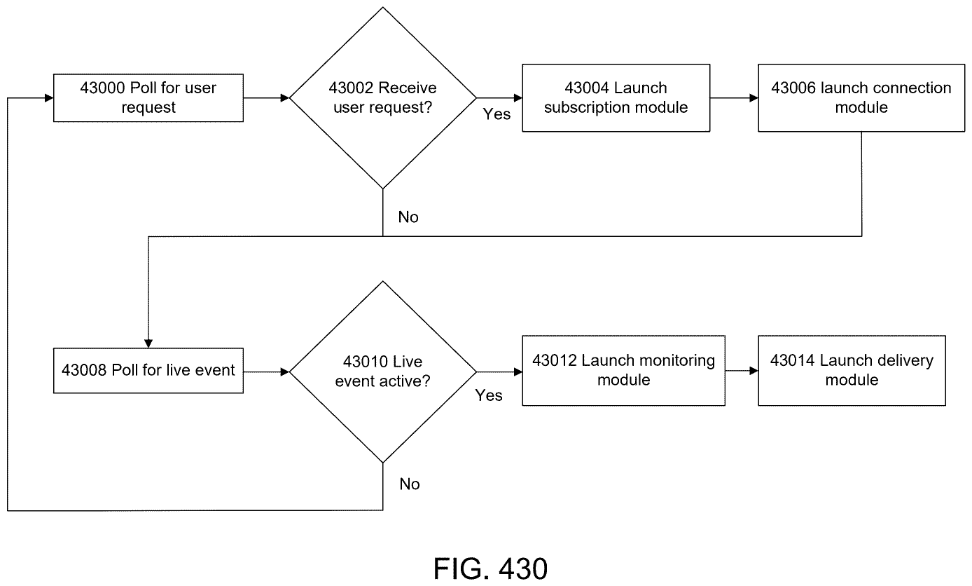

FIG. 430 illustrates a sportogram base module, according to an embodiment.

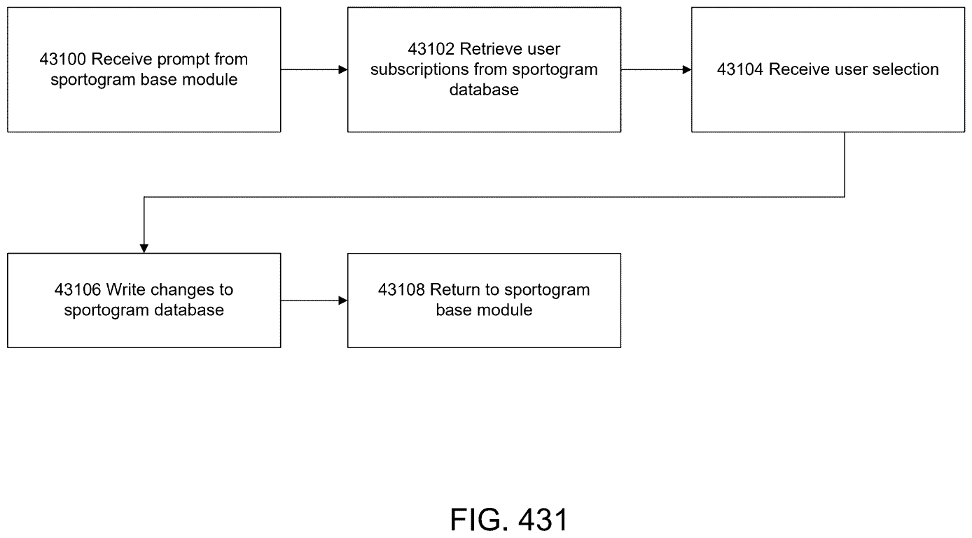

FIG. 431 illustrates a subscription module, according to an embodiment.

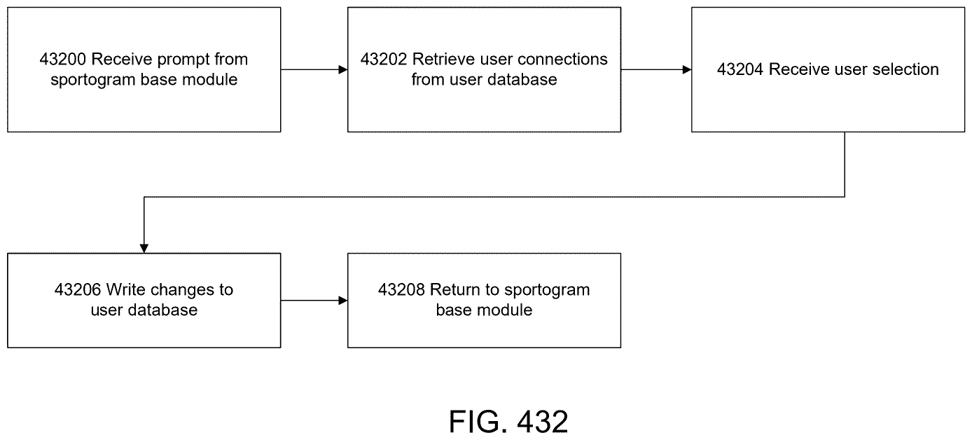

FIG. 432 illustrates a connection module, according to an embodiment.

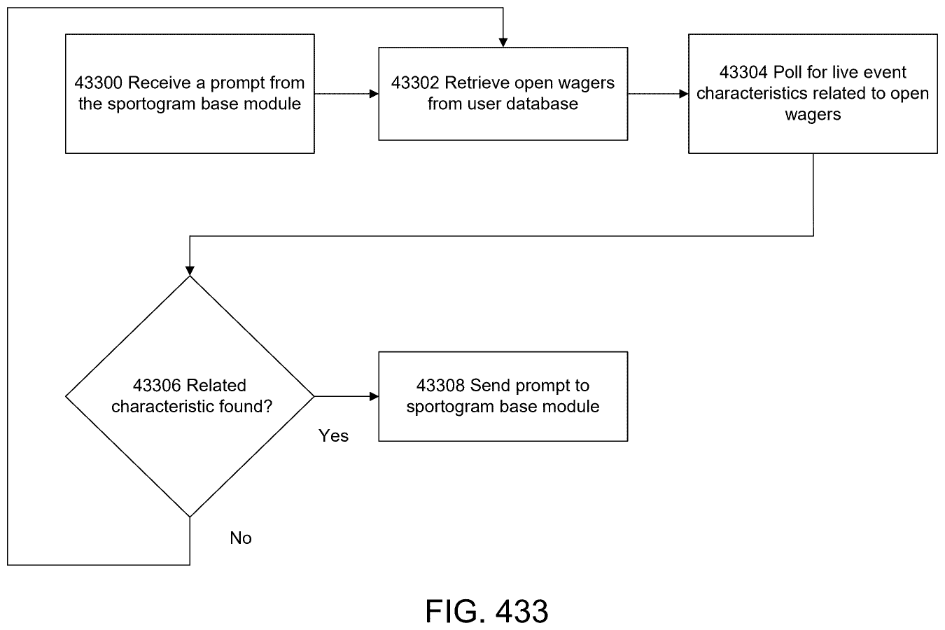

FIG. 433 illustrates a monitoring module, according to an embodiment.

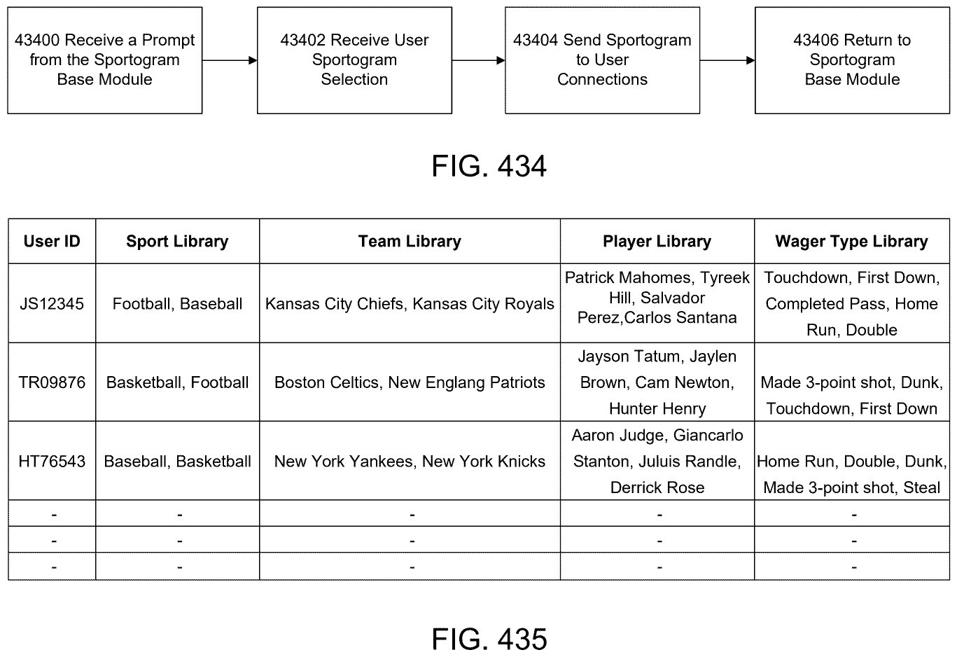

FIG. 434 illustrates a delivery module, according to an embodiment.

FIG. 435 illustrates a sportogram database, according to an embodiment.

FIG. 429 is a system for celebrating or taunting users of a wagering network. This system may include a live event 42902, for example, a sporting event such as a football, basketball, baseball, or hockey game, tennis match, golf tournament, eSports, or digital game, etc. The live event 42902 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 42902, such as the score of an American football game or the run line in a baseball game, or a series of actions in the live event 42902. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 42902 or at another location.

Further, embodiments may include a plurality of sensors 42904 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 42904 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 42906 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 42906 may be communicatively coupled to a peer-to-peer wagering network 42914, which may perform real-time analysis on the type of play and the result of the play. The cloud 42906 may also be synchronized with game situational data such as the time of the game, the score, location on the field, weather conditions, and the like, which may affect the choice of play utilized. For example, in an exemplary embodiment, the cloud 42906 may not receive data gathered from the sensors 42904 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 42908 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 42908 could be an optional component and may be utilized in a situation where a paired wearable device employs the mobile device 42908 for additional memory or computing power or connection to the internet.

Further, embodiments may include a wagering software application or a wagering app 42910, which is a program that enables the user to place bets on individual plays in the live event 42902, streams audio and video from the live event 42902, and features the available wagers from the live event 42902 on the mobile device 42908. The wagering app 42910 allows the user to interact with the wagering network 42914 to place bets and provide payment/receive funds based on wager outcomes.

Further, embodiments may include a mobile device database 42912 that may store some or all the user's data, the live event 42902, or the user's interaction with the wagering network 42914.

Further, embodiments may include the wagering network 42914, which may perform real-time analysis on the type of play and the result of a play or action. The wagering network 42914 (or the cloud 42906) may also be synchronized with game situational data, such as the time of the game, the score, location on the field, weather conditions, and the like, which may affect the choice of play utilized. For example, in an exemplary embodiment, the wagering network 42914 may not receive data gathered from the sensors 42904 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 42914 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 42916, which may contain data relevant to all users of the wagering network 42914 and may include, but is not limited to, a user ID, a device identifier, a paired device identifier, wagering history, or wallet information for the user. The user database 42916 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 42916 may contain betting lines and search queries. The user database 42916 may be searched based on a search criterion received from the user. Each betting line may include but is not limited to, a plurality of betting attributes such as at least one of the following: the live event 42902, a team, a player, an amount of wager, etc. The user database 42916 may include, but is not limited to, information related to all the users involved in the live event 42902. In one exemplary embodiment, the user database 42916 may include information for generating a user authenticity report and a wagering verification report. Further, the user database 42916 may be used to store user statistics like, but not limited to, the retention period for a particular user, frequency of wagers placed by a particular user, the average amount of wager placed by each user, etc.

Further, embodiments may include a historical plays database 42918 that may contain play data for the type of sport being played in the live event 42902. For example, in American Football, for optimal odds calculation, the historical play data may include metadata about the historical plays, such as time, location, weather, previous plays, opponent, physiological data, etc.

Further, embodiments may utilize an odds database 42920—that may contain the odds calculated by an odds calculation module 42922—to display the odds on the user's mobile device 42908 and take bets from the user through the mobile device wagering app 42910.

Further, embodiments may include the odds calculation module 42922, which may utilize historical play data to calculate odds for in-play wagers.

Further, embodiments may include a sportogram base module 42924, which may allow users to communicate with each other through pictures or animations related to at least one aspect of a wagered upon live event 42902. For example, a first user may have bet on the current play in an American football game resulting in a complete pass. The supposed play may end in a sack of the quarterback. A second user may send a sportogram in the form of an animation of a quarterback being sacked to the first user to taunt the first user. The sportogram base module 42924 may prompt the subscription module 42926 to allow users to subscribe to one or more libraries of sportograms. The connection module 42928 may be prompted to allow users to create connections to one or more other users or a group of users. Both the subscription module 42926 and the connection module 42928 may be called by a user at any time with or without a live event 42902 being active. When one or more live events 42902 are active, the monitoring module 42930 may monitor the user database 42916 for any open wagers. Users or groups of users connected to the user who placed the open wager may be identified. For example, a contact list of a first user who placed a wager on the current play of the Kansas City Chiefs' game that resulted in a pass or the Chiefs winning the game. The monitoring module 42930 may identify one or more characteristics of the live event 42902 that may be related to the open wager, and the delivery module 42932 may be prompted to allow the identified connected users to send one or more sportograms to the user who placed the wager that may be related to the one or more characteristics of the live event 42902 that prompted the notification. For example, a contact of the user who placed a wager on the current play of the Kansas City Chiefs' game resulting in a pass may be notified of the play resulting in a sack and can send an animation of a quarterback being sacked to the user who placed the wager.

Further, embodiments may include a subscription module 42926, which may allow users to subscribe to one or more libraries of sportograms. For example, a user may pay for access to a library of images or animations related to their favorite team, sport, player, wager type, etc., that they may send to another user when a characteristic of the live event 42902 is relevant to at least one placed wager.

Further, embodiments may include a connection module 42928 that may allow users to create connections between themselves and other users or groups of users. For example, these connections may allow connected users to send sportograms related to one or more characteristics of the live event 42902 and at least one wager to each other.

Further, embodiments may include a monitoring module 42930 that may monitor the live event 42902 for characteristics related to one or more wagers. When a characteristic of the live event 42902 is identified as being related to a placed wager, the monitoring module 42930 may notify one or more connected users.

Further, embodiments may include a delivery module 42932, which may allow the users to select one or more sportograms related to both a wager placed by a connected user and a characteristic of the live event 42902 to send in response to the notification delivered by the monitoring module 42930.

Further, embodiments may include a sportogram database 42934 that may contain one or more libraries of sprotograms and the users of the wagering network 42914 that are subscribed to each library.

FIG. 430 illustrates the sportogram base module 42924. The process may begin with the sportogram base module 42924 polling, at step 43000, for a user request. For example, a user may request to sign up for a subscription to use the sportograms to send to their connections on the wagering network 42914. Then the sportogram base module 42924 may determine, at step 43002, if a request is received from the user. For example, a user may request to sign up for a subscription to use the sportograms to send to their connections on the wagering network 42914. Then the sportogram base module 42924 may launch, at step 43004, the subscription module 42926. For example, the subscription module 42926 may begin with the subscription module 42926 receiving a prompt from the sportogram base module 42924. For example, the sportogram base module 42924 may receive a request from a user that they desire to subscribe to the sportograms and the sportogram base module 42924 may initiate the subscription module 42926. Then the subscription module 42926 may retrieve the user subscriptions from the sportogram database 42934. For example, the subscription module 42926 may use the user ID to filter the sportogram database 42934 to determine the sportograms that the user currently has access to. The subscription module 42926 may receive the user selection. For example, the user may select from a various list of available sportogram libraries stored in the sportogram database 42934, such as sportogram libraries for various sports, teams, players, wager types, etc. Then the subscription module 42926 may write the changes to the sportogram database 42934. For example, if the user selected baseball, Kansas City Chiefs, or Patrick Mahomes, the subscription module 42926 may enter the selection in the sportogram database 42934 to allow the user access to the sportograms in those sportogram libraries. Then the subscription module 42926 may return to the sportogram base module. The sportogram base module 42924 may launch, at step 43006, the connection module 42928. For example, the connection module 42928 may begin with the connection module 42928 receiving a prompt from the sportogram base module 42924. For example, the user may desire to add or select other users on the wagering network 42914 as one of their connected users, such as a friend list, contact list, etc., and the sportogram base module 42924 may initiate the connection module 42928. Then the connection module 42928 may retrieve the user connections from the user database 42916. For example, the connection module 42928 may filter the user database 42916 on the user ID to determine the current users that the user ID is connected to, such as a friends list, contact list, etc. The connection module 42928 may receive the user selection. For example, the user may select a user to connect to by selecting a user ID, full name, username, e-mail address, phone number, etc., to add the other user as a connected user. Then the connection module 42928 may write the changes to the user database 42916. For example, after the user selects another user to connect to the connection module 42928 may store the connected user in the user database 42916 so that the user is connected through a contact list, friend list, etc. Then the connection module 42928 may return to the sportogram base module 42924. If there is no request from the user or after launching the connection module 42928, the sportogram base module 42924 may continuously poll, at step 43008, for the live event 42902. For example, the sportogram base module 42924 may be determining if there is a live event currently being performed, such as an American football event of the Kansas City Chiefs vs. the Denver Broncos. Then the sportogram base module 42924 may determine, at step 43010, if the live event 42902 is active. If the live event 42902 is not active, then the sportogram base module 42924 may return to continuously polling for a user request. If the live event 42902 is active, then the sportogram base module 42924 may launch, at step 43012, the monitoring module 42930. For example, the monitoring module 42930 may begin with the monitoring module 42930 receiving a prompt from the sportogram base module 42924. For example, the sportogram base module 42924 may determine that a live event 42902 is currently active and may send the live event 42902 data to the monitoring module 42930, such as the sport and the teams involved in the live event 42902. Then the monitoring module 42930 may retrieve the open wagers from the user database 42916. For example, the monitoring module 42930 may receive the user ID from the sportogram base module 42924 and filter the user database 42916 on all the open wagers that the user currently has. In some embodiments, the user database 42916 may be filtered for the open wagers for the connected users of the user ID, such as users that are in a friends list, contact list, etc. Then the monitoring module 42930 may continuously poll for live event characteristics related to the available wagers retrieved from the user database 42916. For example, if the user had an open wager that Patrick Mahomes of the Kansas City Chiefs would complete his next pass attempt and in the live event the Kansas City Chiefs have the ball, and the first down has just been completed by Patrick Mahomes throwing a pass to Tyreck Hill, then the related characteristics may be that Patrick Mahomes has just completed a pass. In some embodiments, the related characteristics may be that the Kansas City Chiefs are on offense, first down has just been completed, etc. In some embodiments, the characteristics may be the teams involved, players involved, etc., that are similar to the open wager. The monitoring module 42930 may determine if a related characteristic is found. If a related characteristic is not found, then the monitoring module 42930 may return to retrieving the open wagers from the user database 42916. For example, if the user had an open wager that Patrick Mahomes of the Kansas City Chiefs would complete his next pass attempt and in the live event the Kansas City Chiefs have the ball, and the first down has just been completed by Patrick Mahomes throwing a pass to Tyreck Hill, then the related characteristics may be that Patrick Mahomes has just completed a pass. In some embodiments, the related characteristics may be that the Kansas City Chiefs are on offense, first down has just been completed, etc. In some embodiments, the characteristics may be the teams involved, players involved, etc., that are similar to the open wager. If a related characteristic is found, then the monitoring module 42930 may send a prompt to the sportogram base module 42924. For example, the prompt that the monitoring module 42930 may send to the sportogram base module 42924 may be the sport, the team, the players involved, the wager type, etc., that is from the related characteristic. Then the sportogram base module 42924 may launch, at step 43014, the delivery module 42932. For example, the delivery module 42932 may begin with the delivery module 42932 receiving a prompt from the sportogram base module 42924. For example, the prompt that the sportogram base module 42924 may send may be the sport, the team, the players involved, the wager type, etc., that is from the related characteristic. Then the delivery module 42932 may receive the user sportogram selection. For example, the user may be notified of the related characteristic from an open or closed wager in which, once prompted by the sportogram base module 42924, the user may select a sportogram from the available libraries from the sportogram database 42934 in which the user has access to through their subscription. The user may select a sportogram from a library that they have access to, and the user may send the sportogram to the connected users, such as users on their friends' list, contact list, etc. In some embodiments, the user may select the connected user they desire to send the sportogram to. In some embodiments, the sportogram database 42934 may be filtered using the related characteristics to display the relevant sportograms to the user so that they can quickly send relevant sportograms to their connected users, such as relevant sports sportograms, relevant team sportograms, relevant player sportograms, or related wager type sportograms. Then the delivery module 42932 may send the selected sportogram to the user connections. For example, the delivery module 42932 may receive the selected sportogram and may send the sportogram to the connected users. In some embodiments, the user may select the connected user they desire to send the sportogram to. In some embodiments, the sportogram database 42934 may be filtered using the related characteristics to display the relevant sportograms to the user so that they can quickly send relevant sportograms to their connected users, such as relevant sports sportograms, relevant team sportograms, relevant player sportograms, or related wager type sportograms. The delivery module 42932 may return to the sportogram base module 42924.

FIG. 431 illustrates the subscription module 42926. The process may begin with the subscription module 42926, receiving, at step 43100, a prompt from the sportogram base module 42924. For example, the sportogram base module 42924 may receive a request from a user that they desire to subscribe to the sportograms and the sportogram base module 42924 may initiate the subscription module 42926. Then the subscription module 42926 may retrieve, at step 43102, the user subscriptions from the sportogram database 42934. For example, the subscription module 42926 may use the user ID to filter the sportogram database 42934 to determine the sportograms that the user currently has access to. The subscription module 42926 may receive, at step 43104, the user selection. For example, the user may select from a various list of available sportogram libraries stored in the sportogram database 42934, such as sportogram libraries for various sports, teams, players, wager types, etc. Then the subscription module 42926 may write, at step 43106, the changes to the sportogram database 42934. For example, if the user selected baseball, Kansas City Chiefs, or Patrick Mahomes, the subscription module 42926 may enter the selection in the sportogram database 42934 to allow the user access to the sportograms in those sportogram libraries. Then the subscription module 42926 may return, at step 43108, to the sportogram base module.

FIG. 432 illustrates the connection module 42928. The process may begin with the connection module 42928 receiving, at step 43200, a prompt from the sportogram base module 42924. For example, the user may desire to add or select other users on the wagering network 42914 as one of their connected users, such as a friend list, contact list, etc., and the sportogram base module 42924 may initiate the connection module 42928. Then the connection module 42928 may retrieve, at step 43202, the user connections from the user database 42916. For example, the connection module 42928 may filter the user database 42916 on the user ID to determine the current users that the user ID is connected to, such as a friends list, contact list, etc. The connection module 42928 may receive, at step 43204, the user selection. For example, the user may select a user to connect to by selecting a user ID, full name, username, e-mail address, phone number, etc., to add the other user as a connected user. Then the connection module 42928 may write, at step 43206, the changes to the user database 42916. For example, after the user selects another user to connect to the connection, module 42928 may store the connected user in the user database 42916 so that the user is connected through a contact list, friend list, etc. Then the connection module 42928 may return, at step 43208, to the sportogram base module 42924.

FIG. 433 illustrates the monitoring module 42930. The process may begin with the monitoring module 42930, receiving, at step 43300, a prompt from the sportogram base module 42924. For example, the sportogram base module 42924 may determine that a live event 42902 is currently active and may send the live event 42902 data to the monitoring module 42930, such as the sport and the teams involved in the live event 42902. Then the monitoring module 42930 may retrieve, at step 43302, the open wagers from the user database 42916. For example, the monitoring module 42930 may receive the user ID from the sportogram base module 42924 and filter the user database 42916 on all the open wagers that the user currently has. In some embodiments, the user database 42916 may be filtered for the open wagers for the connected users of the user ID, such as users that are in a friends list, contact list, etc. Then the monitoring module 42930 may continuously poll, at step 43304, for live event characteristics related to the available wagers retrieved from the user database 42916. For example, if the user had an open wager that Patrick Mahomes of the Kansas City Chiefs would complete his next pass attempt and in the live event the Kansas City Chiefs have the ball, and the first down has just been completed by Patrick Mahomes throwing a pass to Tyreek Hill, then the related characteristics may be that Patrick Mahomes has just completed a pass. In some embodiments, the related characteristics may be that the Kansas City Chiefs are on offense, first down has just been completed, etc. In some embodiments, the characteristics may be the teams involved, players involved, etc., that are similar to the open wager. The monitoring module 42930 may determine, at step 43306, if a related characteristic is found. If a related characteristic is not found, then the monitoring module 42930 may return to retrieving the open wagers from the user database 42916 at step 43302. For example, if the user had an open wager that Patrick Mahomes of the Kansas City Chiefs would complete his next pass attempt and in the live event the Kansas City Chiefs have the ball, and the first down has just been completed by Patrick Mahomes throwing a pass to Tyreck Hill, then the related characteristics may be that Patrick Mahomes has just completed a pass. In some embodiments, the related characteristics may be that the Kansas City Chiefs are on offense, first down has just been completed, etc. In some embodiments, the characteristics may be the teams involved, players involved, etc., that are similar to the open wager. If there is a related characteristic, then the monitoring module 42930 may send, at step 43308, a prompt to the sportogram base module 42924. For example, the prompt that the monitoring module 42930 may send to the sportogram base module 42924 may be the sport, the team, the players involved, the wager type, etc., that is from the related characteristic.

FIG. 434 illustrates the delivery module 42932. The process may begin with the delivery module 42932, receiving, at step 43400, a prompt from the sportogram base module 42924. For example, the prompt that the sportogram base module 42924 may send may be the sport, the team, the players involved, the wager type, etc., that is from the related characteristic. Then the delivery module 42932 may receive, at step 43402, the user sportogram selection. For example, the user may be notified of the related characteristic from an open or closed wager in which, once prompted by the sportogram base module 42924, the user may select a sportogram from the available libraries from the sportogram database 42934 in which the user has access to through their subscription. The user may select a sportogram from a library that they have access to, and the user may send the sportogram to the connected users, such as users on their friends' list, contact list, etc. In some embodiments, the user may select the connected user they desire to send the sportogram to. In some embodiments, the sportogram database 42934 may be filtered using the related characteristics to display the relevant sportograms to the user so that they can quickly send relevant sportograms to their connected users, such as relevant sports sportograms, relevant team sportograms, relevant player sportograms, or related wager type sportograms. Then the delivery module 42932 may send, at step 43404, the selected sportogram to the user connections. For example, the delivery module 42932 may receive the selected sportogram and may send the sportogram to the connected users. In some embodiments, the user may select the connected user they desire to send the sportogram to. In some embodiments, the sportogram database 42934 may be filtered using the related characteristics to display the relevant sportograms to the user so that they can quickly send relevant sportograms to their connected users, such as relevant sports sportograms, relevant team sportograms, relevant player sportograms, or related wager type sportograms. The delivery module 42932 may return, at step 43406, to the sportogram base module 42924.

FIG. 435 illustrates the sportogram database 42934. The database may contain one or more libraries of sportograms and the users of the wagering network 42914 that are subscribed to each library. For example, the sportogram database 42934 may contain a list of user IDs, such as JS12345, and the available sportogram libraries that the user has access to, for example, the sportogram sports libraries, such as baseball, basketball, football, etc., the team sportogram libraries, such as the Kansas City Chiefs, Kansas City Royals, etc., the individual player sportogram libraries, such as Patrick Mahomes, Tyreck Hill, etc., the wager type sportogram libraries, such as touchdown, first down, etc. In addition, the sportograms may be pictures or animations. For example, the different sportogram libraries may contain pictures or animations of sports, such as baseball, basketball, football, etc., a specific team, such as the Kansas City Chiefs, Kansas City Royals, etc., a specific player, such as Patrick Mahomes, Tyreck Hill, etc., a wager type, such as touchdown, first down, etc.

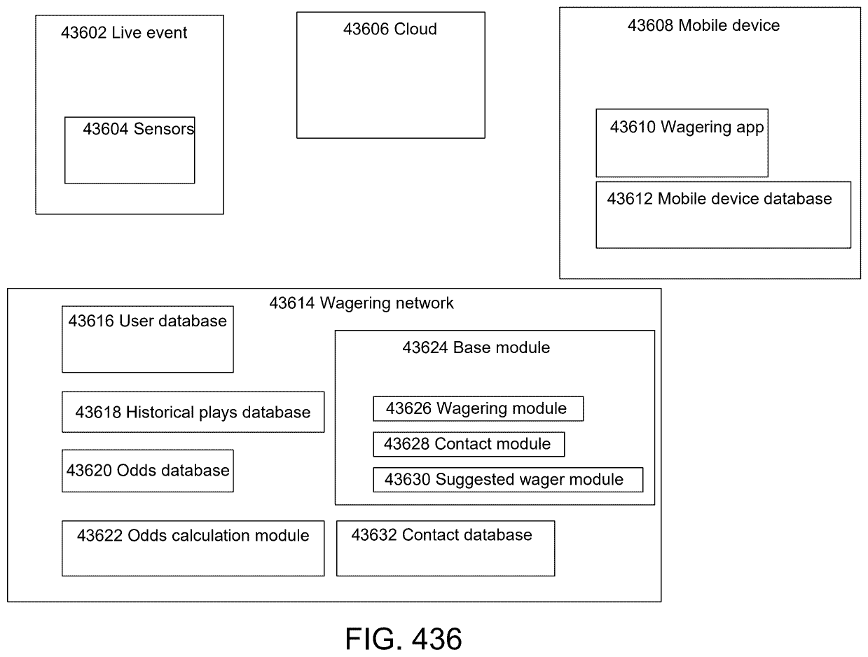

FIG. 436 illustrates a system for suggesting wagers based on wagers made by contacts, according to an embodiment.

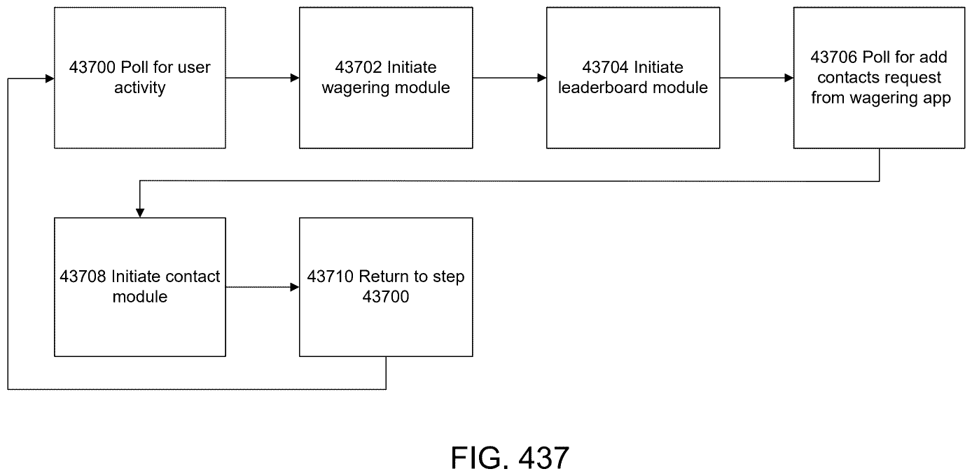

FIG. 437 illustrates a base module, according to an embodiment.

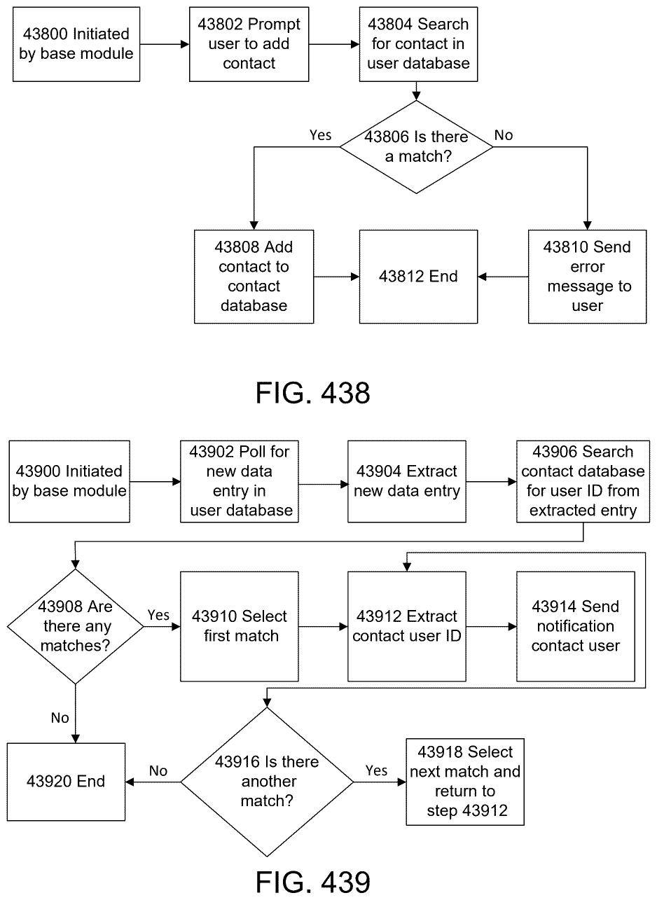

FIG. 438 illustrates a contact module, according to an embodiment.

FIG. 439 illustrates a suggested wager module, according to an embodiment.

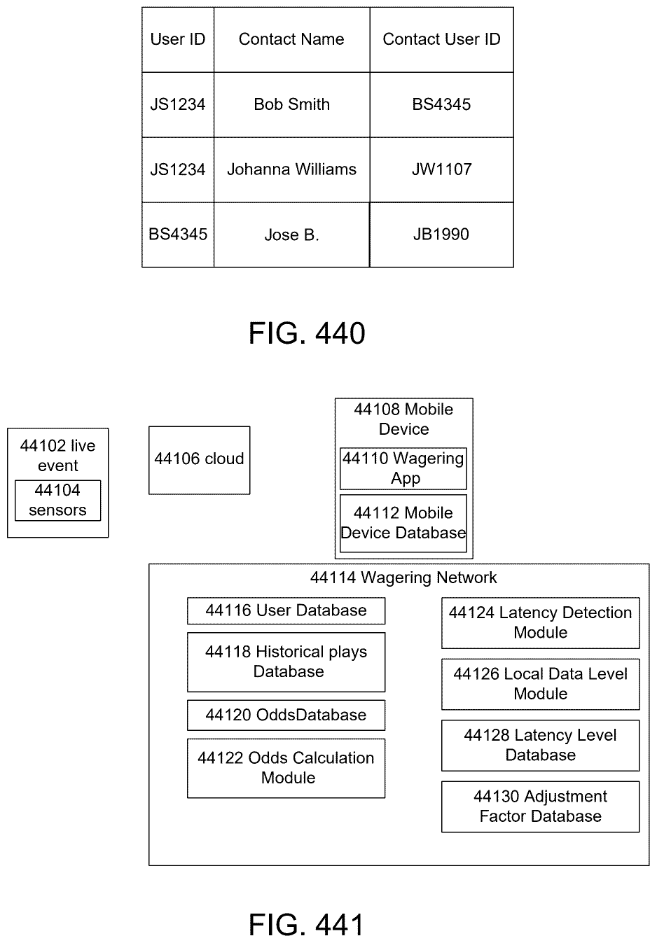

FIG. 440 illustrates a contact database, according to an embodiment.

FIG. 436 is a system for suggesting wagers based on wagers made by contacts. This system may include a live event 43602, for example, a sporting event such as a football, basketball, baseball, or hockey game, tennis match, golf tournament, eSports, or digital game, etc. The live event 43602 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 43602, such as the score of an American football game or the run line in a baseball game, or a series of actions in the live event 43602. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 43602 or at another location.

Further, embodiments may include a plurality of sensors 43604 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 43604 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 43606 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 43606 may be communicatively coupled to a wagering network 43614, which may perform real-time analysis on the type of play and the result of the play. The cloud 43606 may also be synchronized with game situational data such as the time of the game, the score, location on the field, weather conditions, and the like, which may affect the choice of play utilized. For example, in an exemplary embodiment, the cloud 43606 may not receive data gathered from the sensors 43604 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 43608 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 43608 could be an optional component and would be utilized in a situation where a paired wearable device employs the mobile device 43608 for additional memory or computing power or connection to the internet.

Further, embodiments may include a wagering software application or wagering app 43610, which is a program that enables the user to place bets on individual plays in the live event 43602, streams audio and video from the live event 43602, and features the available wagers from the live event 43602 on the mobile device 43608. The wagering app 43610 allows the user to interact with the wagering network 43614 to place bets and provide payment/receive funds based on wager outcomes.

Further, embodiments may include a mobile device database 43612 that may store some or all the user's data, the live event 43602, or the user's interaction with the wagering network 43614.

Further, embodiments may include a wagering network 43614, which may perform real-time analysis on the type of play and the result of a play or action. The wagering network 43614 (or cloud 43606) may also be synchronized with game situational data, such as the time of the game, the score, location on the field, weather conditions, and the like, which may affect the choice of play utilized. For example, in an exemplary embodiment, the wagering network 43614 may not receive data gathered from the sensors 43604 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 43614 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 43616, which may contain data relevant to all users of the wagering network 43614, and may include, but is not limited to, a user ID, a device identifier, a paired device identifier, wagering history, or wallet information for the user. The user database 43616 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 43616 may contain betting lines and search queries. The user database 43616 may be searched based on a search criterion received from the user. Each betting line may include but is not limited to, a plurality of betting attributes such as at least one of the live event 43602, a team, a player, an amount of wager, etc. The user database 43616 may include, but is not limited to, information related to all the users involved in the live event 43602. In one exemplary embodiment, the user database 43616 may include information for generating a user authenticity report and a wagering verification report. Further, the user database 43616 may be used to store user statistics like, but not limited to, the retention period for a particular user, frequency of wagers placed by a particular user, the average amount of wager placed by each user, etc.

Further, embodiments may include a historical play database 43618 that may contain play data for the type of sport being played in the live event 43602. For example, in American Football, for optimal odds calculation, the historical play data may include metadata about the historical plays, such as time, location, weather, previous plays, opponent, physiological data, etc. Further, embodiments may utilize an odds database 43620—that contains the odds calculated by an odds calculation module 43622—to display the odds on the user's mobile device 43608 and take bets from the user through the mobile device wagering app 43610.

Further, embodiments may include the odds calculation module 43622, which may utilize historical play data to calculate odds for in-play wagers.

Further, embodiments may include a base module 43624, which may initiate a wagering module 43626, a contact module 43628, and a suggested wager module 43630.

Further, embodiments may include the wagering module 43626, which may trigger if the user places a wager during the live event. After receiving the prompt, the wagering module 43626 may receive a user selection of the highlighted element. For example, a user may select a highlighted player, like, Aaron Judge of the New York Yankees who is playing in the 3rd inning against Clayton Kershaw of the Los Angeles Dodgers. Further, the wagering module 43626 may retrieve available wagers for the selected element. In one embodiment, the wagering module 43626 may retrieve available wagers from the odds database 43620. In this example, the wagering module 43626 may retrieve the available wagers for Aaron Judge, classifying him as a hitter, such as, a wager of $100 on Aaron Judge hitting a single at odds 4/1 and a wager of $400 on Aaron Judge hitting a home run at odds 5/1 in the 3rd innings of the match between the New York Yankees and Los Angeles Dodgers. Further, the wagering module 43626 may display a menu of available wagers related to the selected element. In one embodiment, the menu may be displayed via the wagering app 43610 on the mobile device 43608. In this example, the wagering module 43626 may display a menu of available wagers for Aaron Judge of the New York Yankees hitting against the Clayton Kershaw of the Los Angeles Dodgers in the 3rd inning of the match. The menu may include a wager of $100 on Aaron Judge hitting a single at odds 4/1 and a wager of $400 on Aaron Judge hitting a home run at odds 3/1. Further, the wagering module 43626 may receive a wager from the user. For example, the user places a wager of $100 on Aaron Judge of the New York Yankees, playing 3rd innings against Clayton Kershaw of the Los Angeles Dodgers and hitting a single at odds 4/1. Further, the wagering module 43626 may constantly monitor the live event 43602 for completion. In one case, when the live event 43602 has concluded, the wagering module 43626 may obtain the results of the live event 43602. For example, the wagering module 43626 may obtain the results of the live event 43602 which may show that Aaron Judge hit a single during the live event 43602. In another case, when the live event 43602 has not concluded, the wagering module 43626 may continue monitoring the live event 43602 for completion. Further, the wagering module 43626 may compare the result of the live event 43602 with the wagers placed by the user to determine a result, i.e., whether the user has won or lost. For example, the user's wager of $100-having Aaron Judge of the New York Yankees playing the 3rd inning against Clayton Kershaw of the Los Angeles Dodgers and hitting a single—is determined to be a win by comparing it with the result of the live event 43602—which had Aaron Judge of New York Yankees playing 3rd innings against Clayton Kershaw of the Los Angeles Dodgers and hitting a single. Based on the comparison of the result of the live event 43602 and the wagers placed by the user, the wagering module 43626 may calculate the balance amount for the user. For example, the user wins the wager of $100 at +400 odds that Aaron Judge will hit a single on the next play, and the result of the live event 43602 is that Aaron Judge hits a single. Thus, the updated balance of the user—with an opening balance of $2000—after the completion of the live event 43602, will be $2000+$400=$2400. Further, the wagering module 43626 may update the account balance of the user who places the wager. In this example, after winning the wager of $100 placed (at odds of 4/1), the wagering module 43626 may update the user's balance to $2400.

Further, embodiments may include the contact module 43628, which may be executed by the base module 43624 if a user executes an icon on the mobile device 43608. This module may request inputs from the user for the contact information of the user's friends. This request for input can be satisfied by entering the friend's contact information. It should be obvious to those skilled in the art that there are many ways to obtain a friend's contact information. For instance, by sending a friend an invite link from the wagering network 43614 which allows them to input their contact information or by searching through a list of contacts, selecting a friend, and allowing that friend to approve being added the list. Once the friend's contact information is received, it may be stored in a contact database 43632.

Further, embodiments may include the suggested wager module 43630, which may be executed by the base module 43624. During the current play of the live event 43602, the module may search the contact database 43632 for the user's friends. The suggested wager module 43630 may then poll to see if/when one of those contacts places a wager. The suggested wager module 43630 may then suggest the same wager to the user.

Further, embodiments may include the contact database 43632, which may store, for each user, the friends on their friends' list. This database may store the performance metrics by time and by play so that all the performance metrics can later be shown on a leaderboard.

FIG. 437 illustrates the base module 43624. The process may begin with the base module 43624 polling, at step 43700, for the user activity. User activity may mean that the user is signed into the wagering app 43610, used the wagering app 43610 in the last minutes, or is actively using the wagering app 43610. Users may be able to set themselves as active or inactive. The base module 43624 may initiate, at step 43702, the wagering module 43626. The wagering module 43626 may allow the user to place wagers on a live event 43602. The base module 43624 may initiate, at step 43704, the suggested wager module 43630. The suggested wager module 43630 may suggest wagers to the user based on wagers made by the user's contacts. The base module 43624 may poll, at step 43706, for a request from the wagering app 43610 to add a new contact. This request may be sent from the mobile device 43608 by the user. For example, the user may press an “add contact” button. The base module 43624 may initiate, at step 43708, the contact module 43628. The contact module 43628 may allow the user to add new contacts, which may be stored in the contact database 43632. The base module 43624 may return, at step 43710, to step 43700.

FIG. 438 illustrates the contact module 43628. The process may begin with the contact module 43628 being initiated, at step 43800, by the base module 43624. The base module 43624 may be prompted to initiate the contact module 43628 after the user selects to add contacts from their mobile device 43608. The contact module 43628 may prompt, at step 43802, the user to add a contact. The user may add a contact by entering the user ID of the contact or with another identifier, for example, the user's name, if the identifier is stored in the user database 43616. The contact module 43628 may search, at step 43804, for a matching user ID, or other identifiers, in the user database 43616. The contact module 43628 may determine, at step 43806, if there is a matching entry in the user database 43616. If there is a matching entry, the contact module 43628 may add, at step 43808, the user ID of the matching entry to the contact database 43632. The user ID of the contact may be stored as the “contact user ID” and associated with the user ID of the user adding the contact. If there is no matching entry, the contact module 43628 may skip to step 43810 and send a notification to the mobile device 43608, such as, “No contact with that user ID, or other identifiers, has been found.” The contact module 43628 may then return to step 43702. The contact module 43628 may end at step 43812.

FIG. 439 illustrates the suggested wager module 43630. The process may begin with the suggested wager module 43630 being initiated at step 43900 by the base module 43624. The suggested wager module 43630 may poll, at step 43902, for a new entry in the user database 43616. A new data entry may be a wager that has been placed. For example, user Joe Smith's recently-placed bet on the baseball game may be saved as a new data entry in the user database 43616. The suggested wager module 43630 may extract, at step 43904, the new data entry from the user database 43616. The suggested wager module 43630 may search, at step 43906, the contact database 43632 for the user ID in the extracted new entry. The suggested wager module 43630 may determine, at step 43908, if there are any matches for the user ID in the contact database 43632. If there are no matches, the suggest wager module 43630 may skip to step 43920 and end. However, if there are matches, the suggested wager module 43630 may select, at step 43910, the first match in the contact database 43632. The suggested wager module 43630 may extract, at step 43912, the contact user ID associated with the matching user ID. The suggested wager module 43630 may send, at step 43914, a notification to the contact, informing them that the user has made a wager. The notification may be sent to the mobile device 43608 that is associated with the contact user ID. This notification may include information about the wager. The notification may link the contact user to the wagering module 43626, allowing them to wager on the same play. For example, if user Joe Smith makes a wager on a baseball game, a notification may be sent to his contacts, like user Bob Smith. User Bob Smith may then receive a notification in the wagering app 43610 on his mobile device 43608 which reads, “Joe Smith just put $30 on the Dodgers getting a home run. Click here to join Joe's bet or bet against him.”. User Bob Smith may then click on the notification and be directed to the wagering module 43626 to place a wager on the play. The suggested wager module 43630 may determine, at step 43916, if there is another match in the contact database 43632. If there is an additional match, the suggested wager module 43630 may select, at step 43918, the next match and return to step 43912. If there are no other matches in the contact database 43632, the suggested wager module 43630 may end at step 43920

FIG. 440 illustrates the contact database 43632. The contact database 43632 may contain user IDs like JS1234. The contact database 43632 may also contain the names of the contacts associated with the user ID, such as, “Bob Smith.” The contact database 43632 may also contain the user ID associated with the contact, for example, BS4345.

FIG. 441 illustrates a system for balancing local and server-side wagering data based on latency, according to an embodiment.

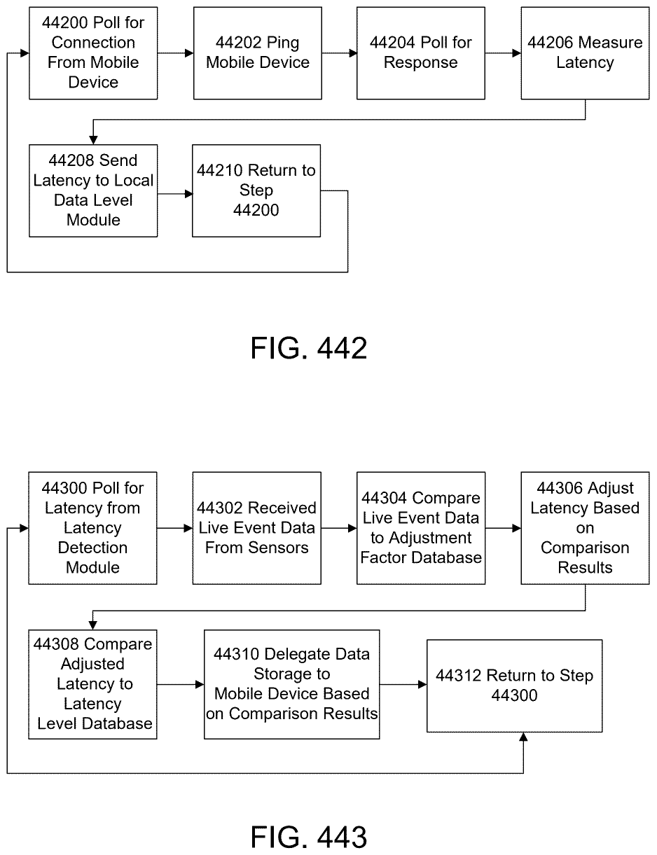

FIG. 442 illustrates a latency detection module, according to an embodiment.

FIG. 443 illustrates a local data level module, according to an embodiment.

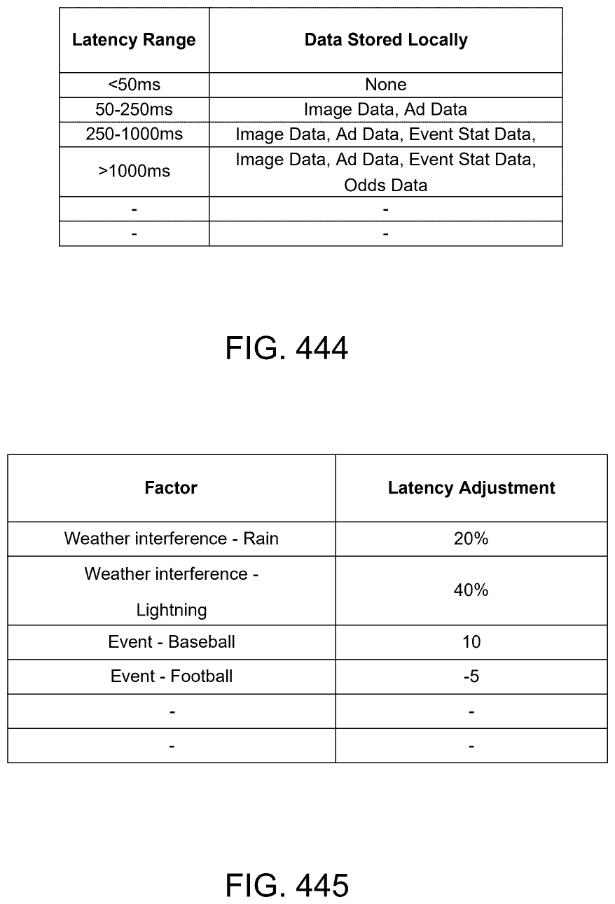

FIG. 444 illustrates a latency level database, according to an embodiment.

FIG. 445 illustrates an adjustment factors database, according to an embodiment.

FIG. 441 is a system for balancing local and server-side wagering data based on latency. This system may include a live event 44102, for example, a sporting event such as a football, basketball, baseball, or hockey game, tennis match, golf tournament, eSports, or digital game, etc. The live event 44102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 44102, such as the score of an American football game or the run line in a baseball game, or a series of actions in the live event 44102. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 44102 or at another location.

Further, embodiments may include a plurality of sensors 44104 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 44104 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 44106 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 44106 may be communicatively coupled to a peer-to-peer wagering network 44114, which may perform real-time analysis on the type of play and the result of the play. The cloud 44106 may also be synchronized with game situational data such as the time of the game, the score, location on the field, weather conditions, and the like, which may affect the choice of play utilized. For example, in an exemplary embodiment, the cloud 44106 may not receive data gathered from the sensors 44104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 44108 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 44108 could be an optional component and would be utilized in a situation where a paired wearable device employs the mobile device 44108 for additional memory or computing power or connection to the internet.

Further, embodiments may include a wagering software application or a wagering app 44110, which is a program that enables the user to place bets on individual plays in the live event 44102, streams audio and video from the live event 44102, and features the available wagers from the live event 44102 on the mobile device 44108. The wagering app 44110 allows the user to interact with the wagering network 44114 to place bets and provide payment/receive funds based on wager outcomes.

Further, embodiments may include a mobile device database 44112 that may store some or all the user's data, the live event 44102, or the user's interaction with the wagering network 44114.

Further, embodiments may include the wagering network 44114, which may perform real-time analysis on the type of play and the result of a play or action. The wagering network 44114 (or the cloud 44106) may also be synchronized with game situational data, such as the time of the game, the score, location on the field, weather conditions, and the like, which may affect the choice of play utilized. For example, in an exemplary embodiment, the wagering network 44114 may not receive data gathered from the sensors 44104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 44114 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 44116, which may contain data relevant to all users of the wagering network 44114 and may include, but is not limited to, a user ID, a device identifier, a paired device identifier, wagering history, or wallet information for the user. The user database 44116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 44116 may contain betting lines and search queries. The user database 44116 may be searched based on a search criterion received from the user. Each betting line may include but is not limited to, a plurality of betting attributes such as at least one of the following: the live event 44102, a team, a player, an amount of wager, etc. The user database 44116 may include, but is not limited to, information related to all the users involved in the live event 44102. In one exemplary embodiment, the user database 44116 may include information for generating a user authenticity report and a wagering verification report. Further, the user database 44116 may be used to store user statistics like, but not limited to, the retention period for a particular user, frequency of wagers placed by a particular user, the average amount of wager placed by each user, etc.

Further, embodiments may include a historical plays database 44118 that may contain play data for the type of sport being played in the live event 44102. For example, in American Football, for optimal odds calculation, the historical play data may include metadata about the historical plays, such as time, location, weather, previous plays, opponent, physiological data, etc.

Further, embodiments may utilize an odds database 44120—that may contain the odds calculated by an odds calculation module 44122—to display the odds on the user's mobile device 44108 and take bets from the user through the mobile device wagering app 44110.

Further, embodiments may include the odds calculation module 44122, which may utilize historical play data to calculate odds for in-play wagers.

Further, embodiments may include a latency detection module 44124, which may detect the latency between the wagering network 44114 and a mobile device 44108. Latency may further be detected between the wagering network and the sensors 44104 or broadcast of the live event 44102.

Further, embodiments may include a local data level module 44126, which may direct the mobile device 44108 to store some types of data locally. Which data is stored locally may be determined by the local data level module 44126 by comparing the latency of the mobile device 44108 from the latency detection module 44124 to a range of latencies stored in a latency level database 44128. The latency may be adjusted based on factors stored in the adjustment factor database 44130.

Further, embodiments may include the latency level database 44128, which may contain ranges of latency and the types of data stored locally on the mobile device 44108 within that range of latency. For example, if latency is very low (<50 ms), all data may be retrieved from a server. If latency is medium (50-250), then time-sensitive systems may be retrieved from the server, but images and functions that do not require real-time updates may be stored locally.

Further, embodiments may include an adjustment factor database 44130, which may contain factors that adjust the latency level ranges corresponding with data stored locally on the mobile device 44108. For example, if the weather is causing high packet loss over wireless networks, then the latency ranges may be altered such that users that have medium latency now fall into the high latency level. Conversely, if the live event is one where there is a lot of downtime between plays, then high latency may not be as detrimental, and the latency levels may be altered such that users that would have medium latency now fall into the low latency level.

FIG. 442 illustrates the latency detection module 44124. The process may begin with the latency detection module 44124 polling, at step 44200, for a connection from the mobile device 44108. The connection may have just begun or may be ongoing. Next, the latency detection module 44124 may ping, at step 44202, the mobile device 44108. Ping may refer to a computer network administration software utility used to test the reachability of a host on an Internet Protocol (IP) network. Ping may be available for virtually all operating systems with networking capability, including most embedded network administration software. A ping may measure the round-trip time for messages sent from the originating host to a destination computer that echoes back to the source. Next, the latency detection module 44124 may poll, at step 44204, for a response to the ping. If no response comes within a set amount of time, the connection may be determined to be lost, and the latency detection module may return to step 44200. Next, the latency detection module 44124 may measure, at step 44206, the latency based on the amount of time it took to get a response from the mobile device 44108. Latency may be measured in milliseconds (ms). Next, the latency detection module 44124 may send, at step 44208, the measured latency to the local data level module 44126. Finally, the latency detection module 44124 may return, at step 44210, to step 44200.

FIG. 443 illustrates the local data level module 44126. The process may begin with the local data level module 44126 polling, at step 44300, for a latency value from the latency detection module 44124. The local data level module 44126 may receive, at step 44302, live event 44102 data from the sensors 44104. This data may include details on the live event 44102, such as the type of event, the teams playing, and the current play. This data may also include details about the environment of the live event 44102, such as weather, wind speed, and electromagnetic interference, which may affect signal strength. The local data level module 44126 may compare, at step 44304, the live event 44102 data to each factor in the adjustment factor database 44130. For example, if the data contains weather data and that weather data shows that it is raining, then a “Weather interference-Rain” factor in the adjustment factor database 44130 may be met. More than one factor may be met. The local data level module 44126 may adjust, at step 44306, the received latency based on comparing the live event 44102 data to the adjustment factor database 44130. For example, the live event 44102 is a baseball game, and it is currently raining at the stadium. User A has 40 ms of latency between the wagering network 44114 and their mobile device 44108. Both the “Weather interference-Rain” and “Event-Baseball” factors are met. The latency may be increased by 10, then increased by 20%, for a total of 60 ms. The order in which the adjustments are applied may be significant, in which case adjustments may be given a value that signifies the order in which they are applied. The local data level module 44126 may compare, at step 44308, the adjusted latency to the latency level database 44128 to determine the latency ranges in which the adjusted latency falls. For example, an adjusted latency of 60 ms may fall into the 50-250 ms range in the latency level database 44128. The local data level module 44126 may delegate, at step 44310, a portion of data storage to the mobile device 44108 based on the latency level of the adjusted latency. For example, if the adjusted latency is between 50-205 ms, image data and advertising data may be stored locally on the mobile device 44108, and all other data may be available from the wagering network 44114. The local data level module 44126 may send instructions to the mobile device 44108 on which data to store locally, may stop the wagering network 44114 from sending that data, or both. The local data level module 44126 may return, at step 44312, to step 44300.

FIG. 444 illustrates the latency level database 44128. The latency level database 44128 may contain ranges of latency, and the types of data that should be store locally on the mobile device 44108 within that range of latency. For example, if latency is very low (<50 ms), all data may be retrieved from the server. If latency is medium (50-250), then time-sensitive systems may be retrieved from the server, but images and functions that do not require real-time updates may be stored locally.

FIG. 445 illustrates the adjustment factors database 44130. The adjustment factor database 44130 may contain factors that adjust the latency level ranges corresponding with data stored locally on the mobile device 44108. For example, if the weather is causing high packet loss over wireless networks, then the latency ranges may be altered such that users that have medium latency may now fall into the high latency level. Conversely, if the live event is one where there is a lot of downtime between plays, then high latency may not be as detrimental, and the latency levels may be altered such that users that have medium latency may now fall into the low latency level. Adjustments may be a flat adjustment such as +10 ms or −5 ms or a percentage adjustment such as a 20% increase or 40% decrease. Multiple adjustments may be applied.

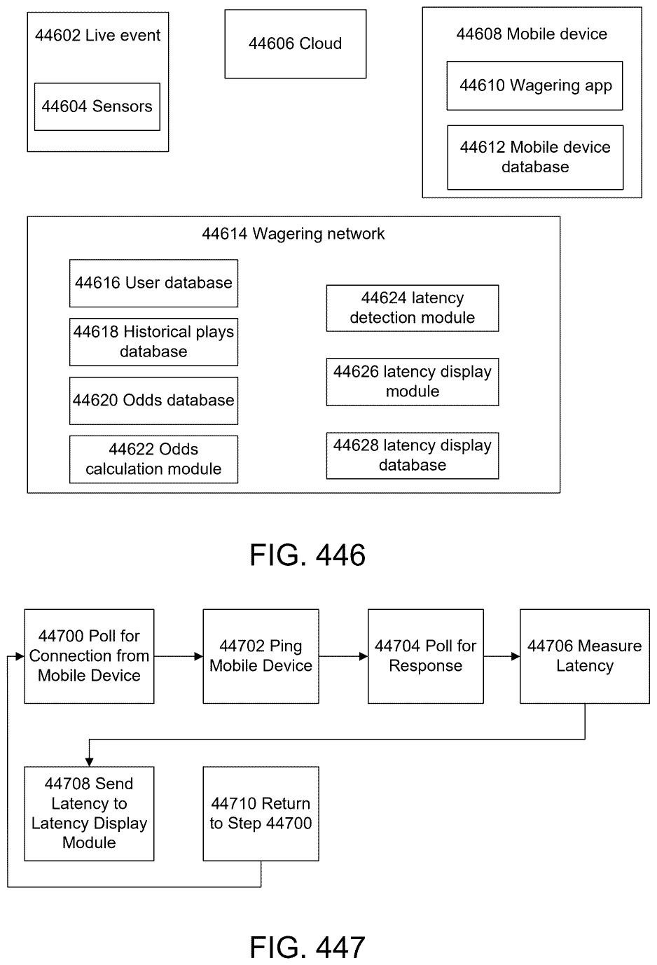

FIG. 446 illustrates is a system for a latency display on a wagering app, according to an embodiment.

FIG. 447 illustrates a latency detection module, according to an embodiment.

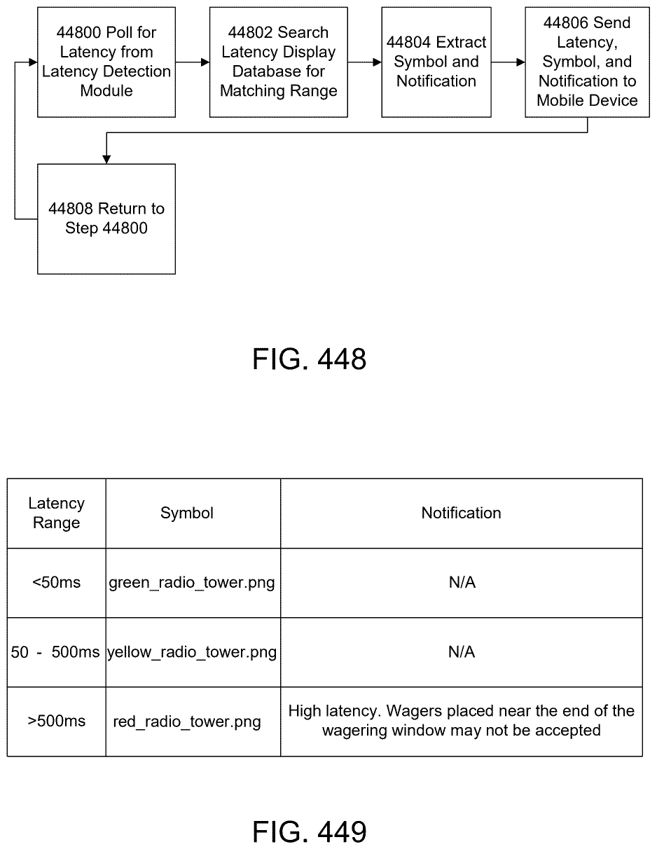

FIG. 448 illustrates a latency display module, according to an embodiment.

FIG. 449 illustrates a latency display database, according to an embodiment.

FIG. 446 is a system for a latency display on a wagering app. This system may include a live event 44602, for example, a sporting event such as a football, basketball, baseball, or hockey game, tennis match, golf tournament, eSports or digital game, etc. The live event 44602 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 44602, such as the score of an American football game or the run line in a baseball game, or a series of actions in the live event 44602. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 44602 or at another location.

Further, embodiments may include a plurality of sensors 44604 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 44604 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 44606 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 44606 may be communicatively coupled to a peer-to-peer wagering network 44614, which may perform real-time analysis on the type of play and the result of the play. The cloud 44606 may also be synchronized with game situational data such as the time of the game, the score, location on the field, weather conditions, and the like, which may affect the choice of play utilized. For example, in an exemplary embodiment, the cloud 44606 may not receive data gathered from the sensors 44604 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 44608 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 44608 could be an optional component and would be utilized in a situation where a paired wearable device employs the mobile device 44608 for additional memory or computing power or connection to the internet.

Further, embodiments may include a wagering software application or a wagering app 44610, which is a program that enables the user to place bets on individual plays in the live event 44602, streams audio and video from the live event 44602, and features the available wagers from the live event 44602 on the mobile device 44608. The wagering app 44610 allows the user to interact with the wagering network 44614 to place bets and provide payment/receive funds based on wager outcomes.

Further, embodiments may include a mobile device database 44612 that may store some or all the user's data, the live event 44602, or the user's interaction with the wagering network 44614.

Further, embodiments may include the wagering network 44614, which may perform real-time analysis on the type of play and the result of a play or action. The wagering network 44614 (or the cloud 44606) may also be synchronized with game situational data, such as the time of the game, the score, location on the field, weather conditions, and the like, which may affect the choice of play utilized. For example, in an exemplary embodiment, the wagering network 44614 may not receive data gathered from the sensors 44604 and may, instead, receive data from an alternative data feed, such as SportsRadar®. This data may be provided substantially immediately following the completion of any play, and may be compared with a variety of team data and league data based on a variety of elements, including the current down, possession, score, time, team, and so forth, as described in various exemplary embodiments herein. The wagering network 44614 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 44616, which may contain data relevant to all users of the wagering network 44614 and may include, but is not limited to, a user ID, a device identifier, a paired device identifier, wagering history, or wallet information for the user. The user database 44616 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 44616 may contain betting lines and search queries. The user database 44616 may be searched based on a search criterion received from the user. Each betting line may include, but is not limited to, a plurality of betting attributes such as at least one of the live event 44602, a team, a player, an amount of wager, etc. The user database 44616 may include, but is not limited to, information related to all the users involved in the live event 44602. In one exemplary embodiment, the user database 44616 may include information for generating a user authenticity report and a wagering verification report. Further, the user database 44616 may be used to store user statistics like, but not limited to, the retention period for a particular user, frequency of wagers placed by a particular user, the average amount of wager placed by each user, etc.

Further, embodiments may include a historical plays database 44618 that may contain play data for the type of sport being played in the live event 44602. For example, in American Football, for optimal odds calculation, the historical play data may include metadata about the historical plays, such as time, location, weather, previous plays, opponent, physiological data, etc.

Further, embodiments may utilize an odds database 44620—that contains the odds calculated by an odds calculation module 44622—to display the odds on the user's mobile device 44608 and take bets from the user through the mobile device wagering app 44610.

Further, embodiments may include the odds calculation module 44622, which utilizes historical play data to calculate odds for in-play wagers.

Further, embodiments may include a latency detection module 44624, which detects the latency between the wagering network 44614 and the mobile device 44608. Latency may further be detected between the wagering network 44614 and the sensors 44604 or broadcast of the live event 44602.

Further, embodiments may include a latency display module 44626, which displays the current latency via the wagering app 44610. The latency display module 44626 may also display an icon based on latency and may identify which features of the wagering app 44610 may be unavailable due to high latency.

Further, embodiments may include a latency display database 44628, containing display icons and an associated latency range. The latency display module 44626 may use the data in the database to determine which icon or notification should be displayed on the wagering app 44610.

FIG. 447 illustrates the latency detection module 44624. The process may begin with the latency detection module 44624 polling, at step 44700, for a connection from the mobile device 44608. The connection may have just begun or may be ongoing. Next, the latency detection module 44624 may ping, at step 44702, the mobile device 44608. Ping may refer to a computer network administration software utility used to test the reachability of a host on an Internet Protocol (IP) network. It is available for virtually all operating systems with networking capability, including most embedded network administration software. A ping measures the round-trip time for messages sent from the originating host to a destination computer echoed back to the source. Next, the latency detection module 44624 may poll, at step 44704, for a response to the ping. If no response comes within a set amount of time, the connection may be determined to be lost, and the latency detection module may return to step 44600. Next, the latency detection module 44624 may measure, at step 44706, the latency based on the amount of time it took to get a response from the mobile device 44608. latency may be measured in milliseconds (ms), or in some other unit. Next, the latency detection module 44624 may send, at step 44708, the measured latency to the latency display module 44626. Finally, the latency detection module 44624 may return, at step 44710, to step 44700. Embodiments may include an algorithm or artificial intelligence to project latency. For example, the combination of geolocation and latency measurements may be used to identify an upcoming latency event, such as driving through a tunnel. The system may project based on the user's location, speed, and heading, when they will reach a tunnel that is likely to impede their connection. A countdown or warning may be displayed for the user to warn them of a window in which their wagers may not be accepted by the system. A similar process may be applied to a user switching from a Wi-Fi network to a cellular network and communicate to the user how much their latency will increase when they switch to the cellular network.

FIG. 448 illustrates the latency display module 44626. The process may begin with the latency display module 44626 polling, at step 44800, for measurement of latency from the latency detection module 44624. Next, the latency display module 44626 may search, at step 44802, the latency display database 44628 for a range of latency in milliseconds that matches the received latency in milliseconds. For example, if the received latency is 33 ms, then the latency range in the latency display database 44628 matches the <50 ms. Next, the latency display module 44626 may extract, at step 44804, the associated symbol and notification from the latency display database 44628 if they exist. Next, the latency display module 44626 may send, at step 44806, the latency in milliseconds, or some other unit, the extracted symbol, and the extracted notification to the mobile device 44608. Finally, the latency display module 44626 may return, at step 44808, to step 44800.

FIG. 449 illustrates the latency display database 44628. The latency display database 44628 may contain ranges of latency, symbols or icons, and text notifications. The latency display module 44626 may use the data in the database to determine which icon or notification should be displayed on the wagering app 44610.

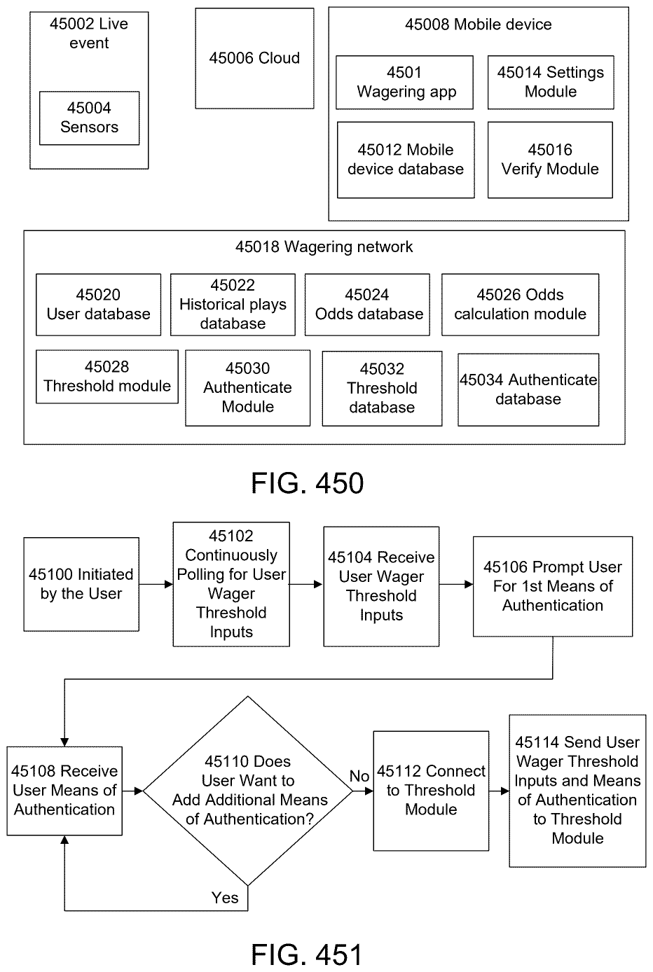

FIG. 450 illustrates a system for authenticating large bets, according to an embodiment.

FIG. 451 illustrates a settings module, according to an embodiment.

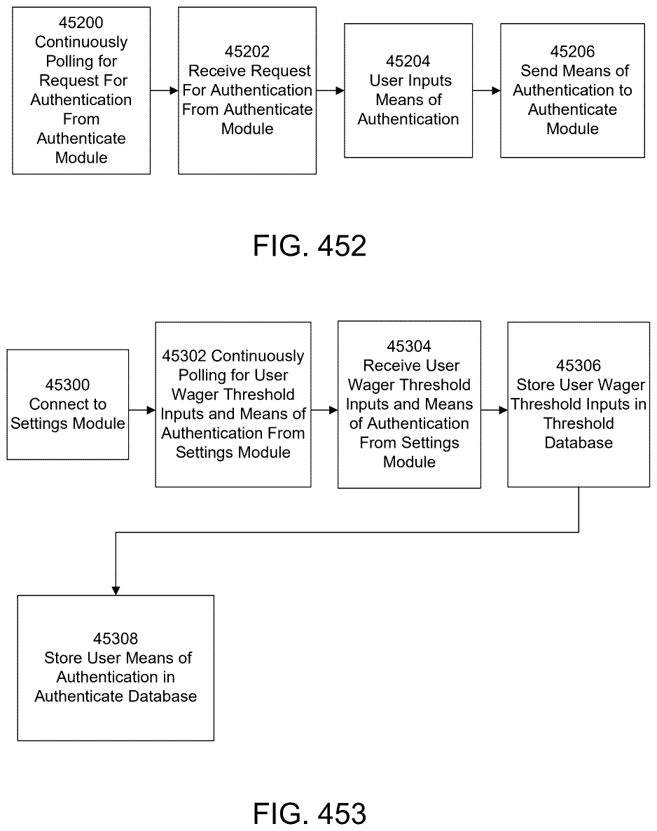

FIG. 452 illustrates a verify module, according to an embodiment.

FIG. 453 illustrates a threshold module, according to an embodiment.

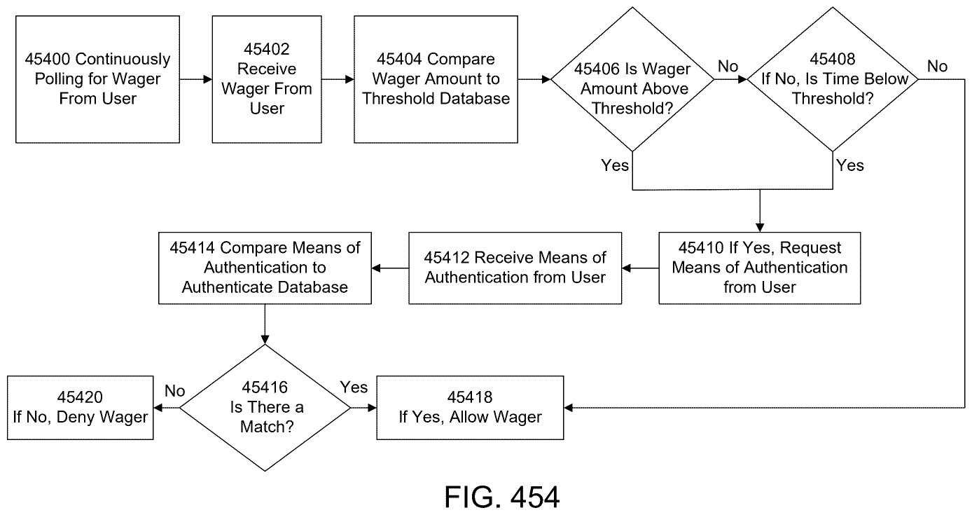

FIG. 454 illustrates an authenticate module, according to an embodiment.

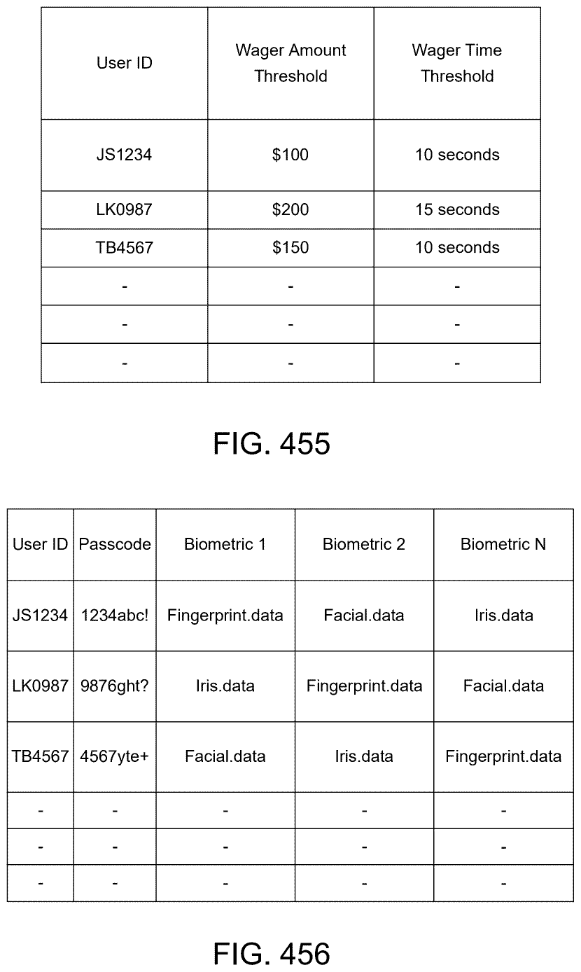

FIG. 455 illustrates a threshold database, according to an embodiment.

FIG. 456 illustrates an authenticate database, according to an embodiment.

FIG. 450 is a system for authenticating large bets. This system may include a live event 45002, for example, a sporting event such as a football, basketball, baseball, or hockey game, tennis match, golf tournament, eSports, or digital game, etc. The live event 45002 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 45002, such as the score of an American football game or the run line in a baseball game, or a series of actions in the live event 45002. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 45002 or at another location.

Further, embodiments may include a plurality of sensors 45004 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 45004 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 45006 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 45006 may be communicatively coupled to a wagering network 45018, which may perform real-time analysis on the type of play and the result of the play. The cloud 45006 may also be synchronized with game situational data such as the time of the game, the score, location on the field, weather conditions, and the like, which may affect the choice of play utilized. For example, in an exemplary embodiment, the cloud 45006 may not receive data gathered from the sensors 45004 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 45008 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 45008 could be an optional component and would be utilized in a situation where a paired wearable device employs the mobile device 45008 for additional memory or computing power or connection to the internet.

Further, embodiments may include a wagering software application or a wagering app 45010, which is a program that enables the user to place bets on individual plays in the live event 45002, streams audio and video from the live event 45002, and features the available wagers from the live event 45002 on the mobile device 45008. The wagering app 45010 allows the user to interact with the wagering network 45018 to place bets and provide payment/receive funds based on wager outcomes.

Further, embodiments may include a mobile device database 45012 that may store some or all the user's data, the live event 45002, or the user's interaction with the wagering network 45018.

Further, embodiments may include a settings module 45014, which may begin with the settings module 45014 being initiated by the user. For example, the user may select the settings option on the wagering app 45010 to adjust their preferences. In some embodiments, the threshold and authentication preferences may be listed as a security setting to prevent the user from placing wagers that are too high or to limit the wager amounts. The settings module 45014 may continuously poll for the user to input the wager thresholds. For example, the user may input thresholds for the amount of money wagered on one bet, such as $100. Also, the user may input threshold time limits, such as if the bet is placed within 10 seconds of the wager being available to the user. These limits may prevent the user from making impulse decisions that are previously deemed inappropriate for the user to make. The settings module 45014 may receive the user wager threshold inputs. For example, the user sets the wager amount threshold to be $100 and the time limit threshold to be 10 seconds from when the wager became available to the user, thereby potentially allowing the user to be notified of the bet and authenticate the bet. This authentication process may allow the user a second opportunity to determine if the wager should be placed. The settings module 45014 may prompt the user for the first means of authentication. For example, the means of authentication may be a numeric, letter, or special character passcodes, such as “1234abc!” or a combination thereof. The means of authentication may also be a biometric measure of the user, such as fingerprint, facial recognition, voice recognition, iris recognition, etc. The settings module 45014 may receive the means of authentication from the user. For example, the means of authentication may be a numeric, letter, or special character passcodes, such as “1234abc!” or a combination thereof. The means of authentication may also be a biometric measure of the user, such as fingerprint, facial recognition, voice recognition, iris recognition, etc. is the settings module 45014 may determine if the user wants to add another means of authentication. If the user wants to add another means of authentication, then the process may return to receive the user's means of authentication. For example, the user may desire to add another means of authentication, such as a numeric, letter, or special character passcodes, such as “1234abc!” or a combination thereof. The means of authentication may also be a biometric measure of the user, such as fingerprint, facial recognition, voice recognition, iris recognition, etc. If the user does not want to add another means of authentication, the settings module 45014 may connect to the threshold module 45028. The settings module 45014 may send the user wager threshold inputs and means of authentication to the threshold module 45028. For example, the settings module 45014 may send the threshold such as the amount of money wagered on one bet, such as $100. Also, the user may input threshold time limits, such as if the bet is placed within 10 seconds of the wager being available to the user. The means of authentication, such as a numeric, letter, or special character passcodes, such as “1234abc! or a combination thereof. The means of authentication may also be a biometric measure of the user, such as fingerprint, facial recognition, voice recognition, iris recognition, etc.

Further, embodiments may include a verify module 45016, which may begin with the verify module 45016 continuously polling for a request for authentication from the authenticate module 45030. For example, the authenticate module 45030 may request authentication from the user if the wager placed exceeds the thresholds set by the user in the settings module 45014. For example, suppose the user wishes for the wager to be placed. In that case, the user may need to present one or multiple means of authentication such as numeric, letter, or special character passcodes, such as “1234abc!” or a combination thereof. The means of authentication may also be a biometric measure of the user, such as fingerprint, facial recognition, voice recognition, iris recognition, etc. The verify module 45016 may receive a request for authentication from the authenticate module 45030. For example, the verify module 45016 may receive a request for a means of authentication such as a numeric, letter, or special character passcodes, such as “1234abc!” or a combination thereof. The means of authentication may be biometric of the user, such as fingerprint, facial recognition, voice recognition, iris recognition, etc. The user may input the means of authentication. For example, the user may input numeric, letter, or special character passcodes, such as “1234abc!” or a combination thereof. The means of authentication may also be a biometric measure of the user, such as fingerprint, facial recognition, voice recognition, iris recognition, etc. The verify module 45016 may send the means of authentication to the authenticate module 45030. For example, the verify module 45016 may send the means of authentication, such as a numeric, letter, or special character passcodes, such as “1234abc!” or a combination thereof. The means of authentication may also be a biometric measure of the user, such as fingerprint, facial recognition, voice recognition, iris recognition, etc.

Further, embodiments may include the wagering network 45018, which may perform real-time analysis on the type of play and the result of a play or action. The wagering network 45018 (or the cloud 45006) may also be synchronized with game situational data, such as the time of the game, the score, location on the field, weather conditions, and the like, which may affect the choice of play utilized. For example, in an exemplary embodiment, the wagering network 45018 may not receive data gathered from the sensors 45004 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 45018 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 45020, which may contain data relevant to all users of the wagering network 45018 and may include, but is not limited to, a user ID, a device identifier, a paired device identifier, wagering history, or wallet information for the user. The user database 45020 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 45020 may contain betting lines and search queries. The user database 45016 may be searched based on a search criterion received from the user. Each betting line may include but is not limited to, a plurality of betting attributes such as at least one of the following: the live event 45002, a team, a player, an amount of wager, etc. The user database 45020 may include, but is not limited to, information related to all the users involved in the live event 45002. In one exemplary embodiment, the user database 45020 may include information for generating a user authenticity report and a wagering verification report. Further, the user database 45020 may be used to store user statistics like, but not limited to, the retention period for a particular user, frequency of wagers placed by a particular user, the average amount of wager placed by each user, etc.

Further, embodiments may include a historical plays database 45022 that may contain play data for the type of sport being played in the live event 45002. For example, in American Football, for optimal odds calculation, the historical play data may include metadata about the historical plays, such as time, location, weather, previous plays, opponent, physiological data, etc.

Further, embodiments may utilize an odds database 45024—that contains the odds calculated by an odds calculation module 45026—to display the odds on the user's mobile device 45008 and take bets from the user through the mobile device wagering app 45010.

Further, embodiments may include the odds calculation module 45026, which utilizes historical play data to calculate odds for in-play wagers.

Further, embodiments may include a threshold module 45028, which may begin with the threshold module 45028 connecting to the settings module 45014. The threshold module 45028 may continuously poll for the user's wager threshold and means of authentication. For example, the threshold module 45028 may continuously poll from the settings module 45014 for thresholds such as the amount of money wagered on one bet, such as $100, time limits, such as if the bet is placed within 10 seconds of the wager being available to the user, and the means of authentication, such as a numeric, letter, or special character passcodes, such as “1234abc!” or a combination thereof, or a biometric measure of the user, such as fingerprint, facial recognition, voice recognition, iris recognition, etc. The threshold module 45028 may receive the user's wager threshold and the user's means of authentication. For example, the threshold module 45028 may receive thresholds from the settings module 45014, such as the amount of money wagered on one bet, such as $100, time limits, such as if the bet is placed within 10 seconds of the wager being available to the user, and the means of authentication, such as a numeric, letter, or special character passcodes, such as “1234abc!” or a combination thereof, or a biometric measure of the user, such as fingerprint, facial recognition, voice recognition, iris recognition, etc. The threshold module 45028 may store the user's wager thresholds in the threshold database 45032. For example, the threshold module 45028 may store the user's thresholds in the threshold database 45032 such as the amount of money wagered on one bet, such as $100 or time limits, such as if the bet is placed within 10 seconds of the wager being available to the user. The threshold module 45028 may store the user's means of authentication in the authenticate database 45034. For example, the threshold module 45028 may store the means of authentication in the authenticate database 45034, such as numeric, letter, or special character passcodes, such as “1234abc!” or a combination thereof, or a biometric measure of the user, such as fingerprint, facial recognition, voice recognition, iris recognition, etc.

Further, embodiments may include an authenticate module 45030, which may begin with the authenticate module 45030 continuously polling for the wager from the user. For example, the user may place a wager through the wagering app 45010, such as the first pitch in the Boston Red Sox vs. New York Yankees event will result in a strike for $200, within 8 seconds of the wagering market being available to the user. The authenticate module 45030 may poll for the user ID, such as JS1234, the wager, such as a first-pitch strike in the Boston Red Sox vs. New York Yankees event, the wager amount, such as $200, and the time between when the wagering market opened and when the user placed the wager, such as 8 seconds. The authenticate module 45030 may receive the wager from the user. For example, the authenticate module 45030 may receive the user ID, such as JS1234, the wager, such as the first-pitch strike in the Boston Red Sox vs. New York Yankees event, the wager amount, such as $200, and the time between when the wagering market opened and when the user placed the wager, such as 8 seconds. The authenticate module 45030 may compare the wager amount to the threshold database 45032. For example, the authenticate module 45030 may compare the received wager amount from the user placing the wager, such as $200, to the threshold database 45032 in which the user's threshold is $100. In some embodiments, the authenticate module 45030 may use the received user ID to filter the threshold database 45032 for the specific user's thresholds. The authenticate module 45030 may determine if the wager amount is above the user's threshold. For example, the authenticate module 45030 may compare the received wager amount from the user placing the wager, such as $200, to the threshold database 45032 wherein the user's threshold is $100, meaning the wager would be over the threshold set by the user in the settings module 45014. If the wager amount is below the threshold, the authenticate module may determine if the time in which the wager was placed is below the threshold stored in the threshold database 45032. For example, if the user had placed a wager under the $100 amount, the authenticate module 45030 may determine if the amount of time from when the wager became available to the user and when the user placed the wager is below the threshold that the user set, such as 10 seconds. Continuing with this example, if the user placed the wager within 8 seconds of the wagering market becoming available, the authenticate module 45030 may request a means of authentication from the user. If the wager amount is above the threshold or if the time limit is below the threshold, then the authenticate module 45030 may request a means of authentication from the verify module 45016. For example, the authenticate module 45030 may send a request to the verify module 45016 for a means of authentication, such as a numeric, letter, or special character passcodes, such as “1234abc!” or a combination thereof, or a biometric measure of the user, such as fingerprint, facial recognition, voice recognition, iris recognition, etc. The authenticate module 45030 may receive the means of authentication from the user. For example, the authenticate module 45030 may receive numeric, letter, or special character passcodes, such as “1234abc!” or a combination thereof, or a biometric measure of the user, such as fingerprint, facial recognition, voice recognition, iris recognition, etc. The authenticate module 45030 may compare the received means of authentication to the means of authentication stored in the authenticate database 45034. For example, the authenticate module 45030 may compare the passcode received from the user to the passcode stored in the authenticate database 45034 to determine if there is a match. In another example, the authenticate module 45030 may compare the biometric of the user, such as fingerprint, facial recognition, voice recognition, iris recognition, etc., to the biometric stored in the authenticate database 45034 to determine if there is a match. The authenticate module 45030 may determine if there is a match between the received means of authentication and the means of authentication stored in the authenticate database 45034. For example, the authenticate module 45030 may compare the passcode received to the passcode stored in the authenticate database 45034 to determine if there is a match. In another example, the authenticate module 45030 may compare the biometric of the user, such as fingerprint, facial recognition, voice recognition, iris recognition, etc., to the biometric stored in the authenticate database 45034 to determine if there is a match. If there is a match, the wager may be allowed. For example, if the means of authentication received is the same as one of the means of authentication stored in the authenticate database 45034, the user may receive a notification that the wager has been placed. If there is no match, the wager may be denied. For example, if authentication received does not match any of the means of authentication stored in the authenticate database 45034, the user may receive a notification that the wager has been denied or canceled.

Further, embodiments may include a threshold database 45032. The threshold database 45032 may be created through the process described in the threshold module 45028, wherein the threshold module 45028 may receive thresholds from the user store them in the threshold database 45032. The threshold database 45032 may contain the user ID, such as JS1234, the wager amount threshold, such as $100, and the wager time threshold, such as 10 seconds. The threshold database 45032 may be used in the process described in the authenticate module 45030, wherein the received data from the user placing the wager may be compared to the threshold database 45032 to determine if any of the parameters, such as the wager amount or time, exceed or reach the threshold inputted by the user. In some embodiments, the threshold database 45032 may contain certain players, teams, events, etc. In some embodiments, the threshold database 45032 may contain pressure parameters for players that perform poorly at the end of events or during high-pressure situations, such as for their team to take the lead or preserve a lead. In some embodiments, the threshold database 45032 may contain pressure situations for the user, such as wagers at the end of an event, if the user is on a losing streak, such as, losing ten straight wagers, or if the user has placed a certain amount of money over a series of wagers, such as $500 over the course of 10 wagers, etc.

Further, embodiments may include an authenticate database 45034. The authenticate database 45034 may be created through the process described in the threshold module 45028, wherein the threshold module 45028 may receive the means of authentication from the user and store them in the authenticate database 45034. The authenticate database 45034 may contain the user ID, such as JS1234, a passcode, such as “1234abc!”, a first biometric, such as a fingerprint, a second biometric, such as facial recognition, and “N” biometric, such as iris recognition, the “N” representing an infinite amount of possible biometrics. The authenticate database 45034 may be used in the authenticate module 45030 if the user needs to provide a means of authentication to place a wager. In some embodiments, the user may be required to provide multiple means of authentication. In some embodiments, the biometric data may initiate another process such as a fingerprint analysis, facial recognition, or iris recognition process to determine if the received biometric is the same biometric stored in the authenticate database 45034. In some embodiments, the data stored in the authenticate database 45034 may be stored in a secure database, such as a database that encrypts the data or is stored in a blockchain.

FIG. 451 illustrates the settings module 45014. The process may begin with the settings module 45014 being initiated, at step 45100, by the user. For example, the user may select the settings option on the wagering app 45010—which allows them to adjust their preferences—thereby initiating the settings module 45014. In some embodiments, threshold and authentication preferences may be listed as a security setting to prevent the user from places wagers that are too high or to limit the wager amounts if the user may have a gambling problem. The settings module 45014 may continuously poll, at step 45102, for the user to input the wager thresholds. For example, the user may input a threshold regarding the amount of money wagered on a single bet, such as $100. Also, the user may input threshold time limits, such as if the bet is placed within 10 seconds of the wager being available to the user. These limits may prevent the user from making impulse decisions that are previously deemed inappropriate for the user to make. The settings module 45014 may receive, at step 45104, the user wager threshold inputs. For example, the settings module 45014 may receive the wager amount threshold of $100 and the time limit threshold of 10 seconds. In another embodiment, an algorithm or artificial intelligence may determine one or more authentication thresholds by observing the wagering behavior of a user, or a cohort of similar users, and identifying wagers that deviate from the expected pattern. This authentication process may provide the user with a second opportunity to determine if the wager should be placed. For example, the system may calculate the historical average wager of a user, or a cohort of related users, and use a variance amount, such as two standard deviations from the average, as the threshold for requiring authentication. The artificial intelligence may also use historical the wagering frequency and timing for a user, or cohort of related users, to identify wagers that require authentication. For example, a user may historically make an average of 5 wagers in an NFL game. However, the user has made 5 wagers in the first five minutes of the current NFL game. This may be flagged by an algorithm as a potential errant wager. In another example, team, player, or sport, that a user, or cohort of similar users, has historically wagered on may be used by the algorithm to identify wagers that may have been made in error. The settings module 45014 may prompt, at step 45106, the user for the first means of authentication. For example, the first means of authentication may be a numeric, letter, or special character passcodes, such as “1234abc!” or a combination thereof, or a biometric measure of the user, such as fingerprint, facial recognition, voice recognition, iris recognition, etc. The settings module 45014 may receive, at step 45108, the means of authentication from the user. For example, the settings module 45014 may receive the means of authentication, such as a numeric, letter, or special character passcodes, such as “1234abc!” or a combination thereof, or a biometric measure of the user, such as fingerprint, facial recognition, voice recognition, iris recognition, etc. In another embodiment, a second factor of authentication may be required. For example, the user may be asked to input an alphanumeric passcode and provide a biometric authentication such as a fingerprint. Another example may include sending an authentication code to a trusted device as a second authentication factor. In another embodiment, the system may define what means of authentication the user provides. For example, the system may require all users to have both an alphanumeric password and a fingerprint biometric as means of authentication. The system may also have different authentication requirements for different users that may be based on factors such as, user geolocation, local regulations, time the user has had an account, number of historical wagers, total amount wagered with the system, etc. For example, a new user may be required to provide an alphanumeric password, a second device, and a biometric for authentication. Whereas a user who has had an account for over a year may only need to provide a one authentication factor. The system may require geolocation specific authentication factors based on local regulations. For example, a jurisdiction may require a government issued photo ID as a means of authentication. The settings module 45014 may determine, at step 45110, if the user wants to add another means of authentication. If so, the process may return to step 45108. For example, the user may desire to add another means of authentication, such as a numeric, letter, or special character passcodes, such as “1234abc!” or a combination thereof, or a biometric measure of the user, such as fingerprint, facial recognition, voice recognition, iris recognition, etc. If the user does not want to add another means of authentication, the settings module 45014 may connect, at step 45112, to the threshold module 45028. The settings module 45014 may send, at step 45114, the user wager threshold inputs and means of authentication to the threshold module 45028. For example, the settings module 45014 may send to the threshold module 45028 the thresholds, such as the amount of money wagered on one bet, such as $100, time limits, such as if the bet is placed within 10 seconds of the wager becoming available to the user or the means of authentication, such as a numeric, letter, or special character passcodes, such as “1234abc!” or a combination thereof, or a biometric measure of the user, such as fingerprint, facial recognition, voice recognition, iris recognition, etc.

FIG. 452 illustrates the verify module 45016. The process may begin with the verify module 45016 continuously polling, at step 45200, for a request for authentication from the authenticate module 45030. For example, the authenticate module 45030 may request authentication from the user if the wager placed exceeds the thresholds set by the user in the settings module 45014. Further, if the user wishes for the wager to be placed, they may need to present one or multiple means of authentication such as numeric, letter, or special character passcodes, such as “1234abc!” or a combination thereof, or a biometric measure of the user, such as fingerprint, facial recognition, voice recognition, iris recognition, etc. The verify module 45016 may receive, at step 45202, a request for authentication from the authenticate module 45030. For example, the verify module 45016 may receive a request for a means of authentication such as a numeric, letter, or special character passcodes, such as “1234abc!” or a combination thereof, or a biometric measure of the user, such as fingerprint, facial recognition, voice recognition, iris recognition, etc. The user may input, at step 45204, the means of authentication. For example, the user may input numeric, letter, or special character passcodes, such as “1234abc!” or a combination thereof, or a biometric measure of the user, such as fingerprint, facial recognition, voice recognition, iris recognition, etc. The verify module 45016 may send, at step 45206, the means of authentication to the authenticate module 45030. For example, the verify module 45016 may send the means of authentication, such as a numeric, letter, or special character passcodes, such as “1234abc!” or a combination thereof, or a biometric measure of the user, such as fingerprint, facial recognition, voice recognition, iris recognition, etc., to the authenticate module 45030.

FIG. 453 illustrates the threshold module 45028. The process may begin with the threshold module 45028 connecting, at step 45300, to the settings module 45014. The threshold module 45028 may continuously poll, at step 45302, for the user's wager threshold and means of authentication from the settings module 45014. For example, the threshold module 45028 may continuously poll from the settings module 45014 for the thresholds, such as the amount of money wagered on one bet, such as $100, time limits, such as if the bet is placed within 10 seconds of the wager being available to the user or the means of authentication, such as numeric, letter, or special character passcodes, such as “1234abc!” or a combination thereof, or a biometric measure of the user, such as fingerprint, facial recognition, voice recognition, iris recognition, etc. The threshold module 45028 may receive, at step 45304, the user's wager threshold and means of authentication. For example, the threshold module 45028 may receive from the settings module 45014, the thresholds, such as the amount of money wagered on one bet, such as $100, time limits, such as if the bet is placed within 10 seconds of the wager being available to the user or the means of authentication, such as numeric, letter, or special character passcodes, such as “1234abc!” or a combination thereof, or a biometric measure of the user, such as fingerprint, facial recognition, voice recognition, iris recognition, etc. The threshold module 45028 may store, at step 45306, the user's wager thresholds in the threshold database 45032. For example, the threshold module 45028 may store in the threshold database 45032 the thresholds, such as the amount of money wagered on one bet, such as $100 or time limits, such as if the bet is placed within 10 seconds of the wager being available to the user. The threshold module 45028 may store, at step 45308, the user's means of authentication in the authenticate database 45034. For example, the threshold module 45028 may stores in the authenticate database 45034 the means of authentication, such as a numeric, letter, or special character passcodes, such as “1234abc!” or a combination thereof or a biometric measure of the user, such as fingerprint, facial recognition, voice recognition, iris recognition, etc.

FIG. 454 illustrates the authenticate module 45030. The process may begin with the authenticate module 45030 continuously polling, at step 45400, for the wager from the user. For example, the user may place a wager through the wagering app 45010, such as the first pitch in the Boston Red Sox vs. New York Yankees event will result in a strike for $200 within 8 seconds of the wagering market becoming available to the user. The authenticate module 45030 may poll for the user ID, such as JS1234, the wager, such as a first-pitch strike in the Boston Red Sox vs. New York Yankees event, the wager amount, such as $200, and the time between when the wagering market opened and when the user placed the wager, such as 8 seconds. The authenticate module 45030 may receive, at step 45402, the wager from the user. For example, the user may place a wager through the wagering app 45010, such as the first pitch in the Boston Red Sox vs. New York Yankees event will result in a strike for $200. The authenticate module 45030 may receive the user ID, such as JS1234, the wager, such as a first-pitch strike in the Boston Red Sox vs. New York Yankees event, the wager amount, such as $200, and the time between when the wagering market opened and when the user placed the wager, such as 8 seconds. The authenticate module 45030 may compare, at step 45404, the wager amount to the threshold database 45032. For example, the authenticate module 45030 may compare the received wager amount from the user placing the wager, such as $200, to the threshold database 45032 wherein the user's threshold is $100. In some embodiments, the authenticate module 45030 may use the received user ID to filter the threshold database 45032 for the specific user's thresholds. The authenticate module 45030 may determine, at step 45406, if the wager amount is above the user's threshold. For example, the authenticate module 45030 may compare the received wager amount received from the user placing the wager, such as $200, to the threshold database 45032. If the wager amount is below the threshold, the authenticate module 45030 may determine, at step 45408, if the time in which the wager was placed is below the threshold stored in the threshold database 45032. For example, if the user had placed a wager under the $100 amount, the authenticate module 45030 may determine if the amount of time from the wager being available to the user placing the wager is below the threshold that the user set, such as 10 seconds. If the wager amount is below the threshold and the time limit is above the threshold, the authenticate module 45030 may skip to step 45418. If the wager amount is above the threshold and/or if the time limit is below the threshold, the authenticate module 45030 may request, at step 45410, a means of authentication from the verify module 45016. For example, the authenticate module 45030 may request a means of authentication from the verify module 45016, such as a numeric, letter, or special character passcode, such as “1234abc!” or a combination thereof, or a biometric measure of the user, such as fingerprint, facial recognition, voice recognition, iris recognition, etc. The authenticate module 45030 may receive, at step 45412, the means of authentication from the user. For example, the authenticate module 45030 may receive numeric, letter, or special character passcodes, such as “1234abc!” or a combination thereof, or a biometric measure of the user, such as fingerprint, facial recognition, voice recognition, iris recognition, etc. The authenticate module 45030 may compare, at step 45414, the received means of authentication to the means of authentication stored in the authenticate database 45034. For example, the authenticate module 45030 may compare the passcode received to the passcode stored in the authenticate database 45034 to determine if there is a match. In another example, the authenticate module 45030 may compare the biometric of the user, such as fingerprint, facial recognition, voice recognition, iris recognition, etc., to the biometric stored in the authenticate database 45034 to determine if there is a match. The authenticate module 45030 may determine, at step 45416, if there is a match between the received means of authentication and the means of authentication stored in the authenticate database 45034. For example, the authenticate module 45030 may compare the passcode received to the passcode stored in the authenticate database 45034 to determine if there is a match. In another example, the authenticate module 45030 may compare the biometric of the user, such as fingerprint, facial recognition, voice recognition, iris recognition, etc., to the biometric stored in the authenticate database 45034 to determine if there is a match. If there is a match, the wager may be allowed at step 45418. For example, if authentication received matches the means of authentication stored in the authentication database 45034, the user may receive a notification that the wager has been placed. If there is not a match, the wager may be denied at step 45420. For example, if authentication received does not match any of the means of authentication stored in the authentication database 45034, the user may receive a notification that the wager has been denied or canceled.

FIG. 455 illustrates the threshold database 45032. The threshold database 45032 may be created through the process described in the threshold module 45028, wherein the threshold module 45028 may receive thresholds from the user, and the thresholds are stored in the threshold database 45032. The threshold database 45032 may contain the user ID, such as JS1234, the wager amount threshold, such as $100, and the wager time threshold, such as 10 seconds. The threshold database 45032 may be used in the process described in the authenticate module 45030 wherein the received data from the user placing the wager is compared to the threshold database 45032 to determine if any of the parameters, such as the wager amount or wager time, exceed or reach the threshold set by the user. In some embodiments, the threshold database 45032 may contain certain players, teams, events, etc. In some embodiments, the threshold database 45032 may contain pressure parameters for players that perform poorly at the end of events or in high-pressure situations, such as for their team to take the lead or preserve a lead. In some embodiments, the threshold database 45032 may contain pressure situations for the user, such as wagers at the end of an event, if the user is on a losing streak, for example, losing ten straight wagers, if the user has placed a certain amount of money over of a series of wagers, such as $500 over the course of 10 wagers, etc.

FIG. 456 illustrates the authenticate database 45034. The authenticate database 45034 is created through the process described in the threshold module 45028, wherein the threshold module 45028 may receive the means of authentication from the user and the means of authentication may be stored in the authenticate database 45034. The authenticate database 45034 may contain the user ID, such as JS1234, a passcode, such as “1234abc!”, a first biometric, such as a fingerprint, a second biometric, such as facial recognition, and “N” biometric, such as iris recognition, the “N” representing an infinite amount of possible biometrics. The authenticate database 45034 may be used in the authenticate module 45030 if the user needs to provide a means of authentication to place a wager. In some embodiments, the user may be required to provide multiple means of authentication. In some embodiments, the biometric data may initiate another process such as a fingerprint analysis, facial recognition, or iris recognition process to determine if the received biometric is the same biometric stored in the authenticate database 45034. In some embodiments, the data stored in the authenticate database 45034 may be stored in a secure database, such as a database that encrypts the data or is stored in a blockchain.

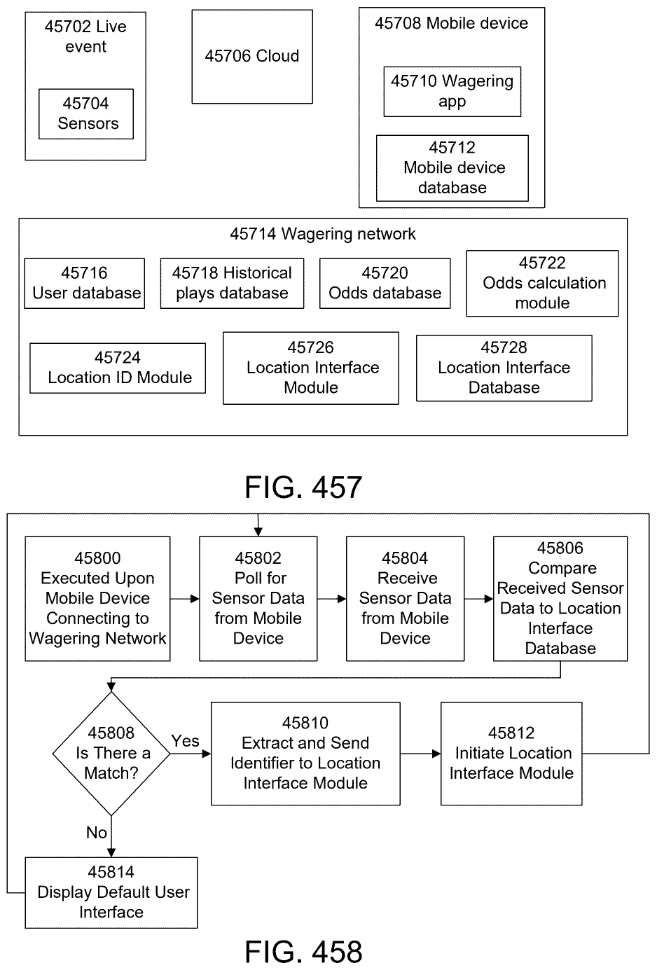

FIG. 457 illustrates a system for a location-based wagering interface, according to an embodiment.

FIG. 458 illustrates a location ID module, according to an embodiment.

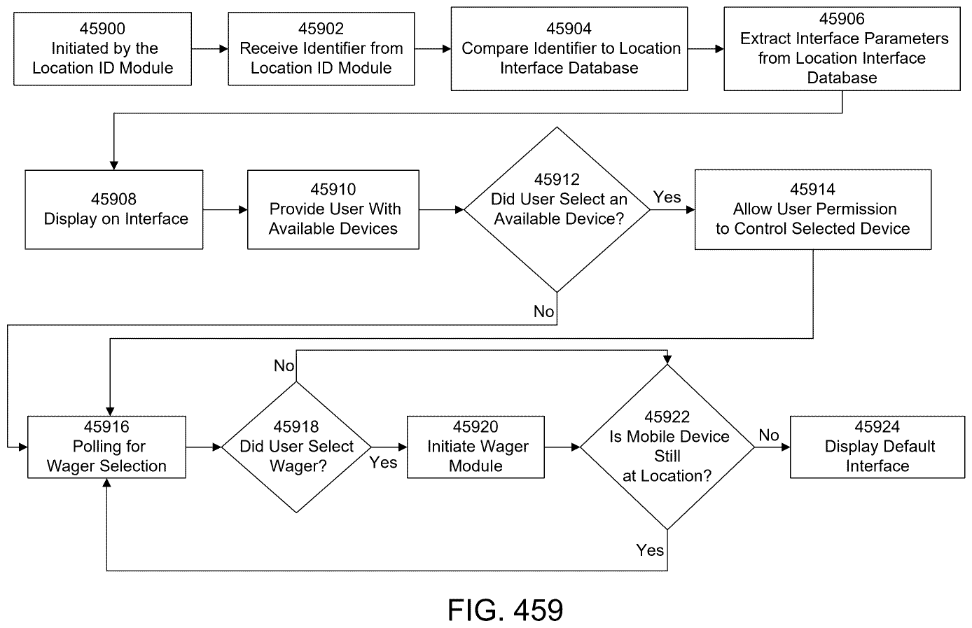

FIG. 459 illustrates a location interface module, according to an embodiment.

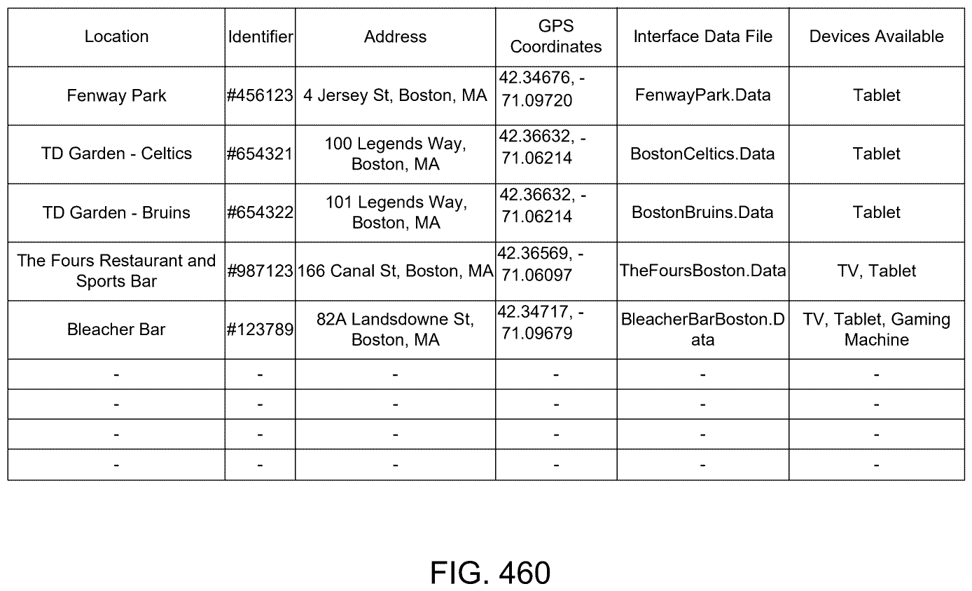

FIG. 460 illustrates a location interface database, according to an embodiment.

FIG. 457 is a system for a location-based wagering interface. This system may include a live event 45702, for example, a sporting event such as a football game, basketball game, baseball game, hockey game, tennis match, golf tournament, eSports or digital game, etc. The live event 45702 will include some number of actions or plays, upon with a user or bettor or customer can place a bet or wager, typically through an entity called a sportsbook. There are numerous types of wagers the bettor can make, including, but not limited to, a straight bet, a money line bet, a bet with a point spread or line that the bettor's team would need to cover if the result of the game with the same as the point spread the user would not cover the spread, but instead the tie is called a push. If the user is betting on the favorite, they are giving points to the opposing side, which is the underdog or longshot. Betting on all favorites is referred to as chalk. This is typically applied to round-robin or other tournaments' styles. There are other types of wagers, including parlays, teasers, and prop bets, that are added games that often allow the user to customize their betting by changing the odds and payouts they receive on a wager. Certain sportsbooks will allow the bettor to buy points, to move the point spread off of the opening line. This will increase the price of the bet, sometimes by increasing the juice, vig, or hold that the sportsbook takes. Another type of wager the bettor can make is an over/under, in which the user bets over or under a total for the live event 45702, such as the score of American football or the run line in baseball, or a series of action in the live event 45702. Sportsbooks have several bets they can handle, a limit of wagers they can take on either side of a bet before they will move the line or odds off of the opening line. Additionally, there are circumstances, such as an injury to an important player such as a listed pitcher, in which a sportsbook, casino, or racino will take an available wager off the board. As the line moves, there becomes an opportunity for a bettor to bet on both sides at different points spreads to middle, and win both bets. Sportsbooks will often offer bets on portions of games, such as first-half bets and half-time bets. Additionally, the sportsbook can offer futures bets on live events in the future. Sportsbooks need to offer payment processing services in order to cash out customers. This can be done at kiosks at the live event 45702 or at another location.

Further, embodiments may include a plurality of sensors 45704 that may be used such as motion sensors, temperature sensors, humidity sensors, optical sensors and cameras such as an RGB-D camera which is a digital camera capable of capturing color (RGB) and depth information for every pixel in an image, microphones, radiofrequency receiver, a thermal imager, a radar device, a lidar device, an ultrasound device, a speaker, wearable devices, etc. Also, the plurality of sensors 45704 may include tracking devices, such as RFID tags, GPS chips, or other such devices embedded on uniforms, in equipment, in the field of play, in the boundaries of the field of play, or on other markers on the field of play. Imaging devices may also be used as tracking devices such as player tracking that provides statistical information through real-time X, Y positioning of players and X, Y, Z positioning of the ball.

Further, embodiments may include a cloud 45706 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, and other communication techniques that are known in the art. The communication network may allow ubiquitous access to shared pools of configurable system resources and higher-level services that can be rapidly provisioned with minimal management effort, often over the internet, and relies on sharing of resources to achieve coherence and economics of scale, like a public utility. In contrast, third-party clouds allow organizations to focus on their core businesses instead of expending resources on computer infrastructure and maintenance. The cloud 45706 may be communicatively coupled to a wagering network 45714, which may perform real-time analysis on the type of play and the result of the play. The cloud 45706 may also be synchronized with game situational data, such as the time of the game, the score, location on the field, weather conditions, and the like, which may affect the choice of play utilized. For example, in an exemplary embodiment, the cloud 45706 may not receive data gathered from the sensors 45704 and may, instead, receive data from an alternative data feed, such as Sports Radar®. This data may be compiled substantially immediately following the completion of any play, and the data from this feed may be compared with a variety of team data and league data based on a variety of elements, including down, possession, score, time, team, and so forth, as described in various exemplary embodiments herein.

Further, embodiments may include a mobile device 45708 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs by combining some of the inputs and outputs. Some devices allow for facial recognition, which may be utilized as an input for different purposes, including authentication and other commands. Some devices provide for voice recognition and inputs, including, e.g., Microsoft KINECT, SIRI for iPhone by Apple, Google Now, or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality, including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control the I/O devices. The I/O controller may control one or more I/O devices, such as e.g., a keyboard and a pointing device, e.g., a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., a USB bus, a SCSI bus, a FireWire bus, an Ethernet bus, a Gigabit Ethernet bus, a Fiber Channel bus, or a Thunderbolt bus. In some embodiments, the mobile device 45708 could be an optional component and would be utilized in a situation where a paired wearable device utilizes the mobile device 45708 as additional memory or computing power or connection to the internet.

Further, embodiments may include a wagering software application or a wagering app 45710, which is a program that enables the user to place bets on individual plays in the live event 45702 and display the audio and video from the live event 45702, along with the available wagers on the mobile device 45708. The wagering app 45710 allows the user to interact with the wagering network 45714 to place bets and provide payment/receive funds based on wager outcomes.

Further, embodiments may include a mobile device database 45712 that may store some or all of the user's data, the live event 45702, or the user's interaction with the wagering network 45714.

Further, embodiments may include the wagering network 45714, which may perform real-time analysis on the type of play and the result of a play or action. The wagering network 45714 (or the cloud 45706) may also be synchronized with game situational data, such as the time of the game, the score, location on the field, weather conditions, and the like, which may affect the choice of play utilized. For example, in an exemplary embodiment, the wagering network 45714 may not receive data gathered from the sensors 45704 and may, instead, receive data from an alternative data feed, such as SportsRadar®. This data may be provided substantially immediately following the completion of any play, and the data from this feed may be compared with a variety of team data and league data based on a variety of elements, including down, possession, score, time, team, and so forth, as described in various exemplary embodiments herein. The wagering network 45714 can offer several software as a service managed services such as user interface service, risk management service, compliance, pricing and trading service, IT support of the technology platform, business applications, game configuration, state-based integration, fantasy sports connection, integration to allow the joining of social media, as well as marketing support services that can deliver engaging promotions to the user.

Further, embodiments may include a user database 45716, which may contain data relevant to all users of the wagering network 45714 and may include, a user ID, a device identifier, a paired device identifier, wagering history, and wallet information for the user. The user database 45716 may also contain a list of user account records associated with a respective user ID. For example, a user account record may include information such as user interests, user personal details such as age, mobile number, etc., sporting events played before, highest wager, favorite sporting event, and current user standings and balance corresponding to the user ID. In addition, the user database 45716 may contain betting lines and search queries. The user database 45716 may be searched based on a search criterion received from the user. Each betting line may include a plurality of betting attributes such as at least one of the live event 45702, a team, a player, an amount of wager, etc. The user database 45716 may include information related to all the users involved in the live event 45702. In one exemplary embodiment, the user database 45716 may include information for generating a user authenticity report and a wagering verification report. Further, the user database 45716 may be used to store user statistics like, but not limited to, the retention period for a particular user, frequency of wagers placed by a particular user, the average amount of wager placed by each user, etc.

Further, embodiments may include a historical play database 45718 that may contain play data for the type of sport being played in the live event 45702. For example, in American Football, for optimal odds calculation, the historical play data may include metadata about the historical plays, such as time, location, weather, previous plays, opponent, physiological data, etc.

Further, embodiments may utilize an odds database 45720 that contains the odds calculated by an odds calculation module 45722 to display the odds on the user's mobile device 45708 and take bets from the user through the mobile device wagering app 45710.

Further, embodiments may include the odds calculation module 45722, which utilizes historical play data to calculate odds for in-play wagers.

Further, embodiments may include a location ID module 45724, which is executed from the wagering network base module (not shown) when the mobile device 45708 is connected to the wagering network 45714. The location ID module 45724 then polls for sensor data from the various sensors located on the mobile device 45708. For example, the mobile device 45708 location may be obtained through GPS data, Wi-Fi data, microphone data, and/or camera data recognizing location-based indicators. The location ID module 45724 then receives the sensor data from the mobile device 45708 and compares this data to a location interface database 45728. If it is determined that there is a match between the received sensor data from the mobile device 45708 and the data stored in the location interface database 45728, the location ID module 45724 extracts the location identifier, sends the location identifier to a location interface module 45726 and initiates the location interface module 45726. If it is determined that there is no match between the received sensor data from the mobile device 45708 and the data stored in the location interface database 45728, then the default user interface is used on the mobile device 45708.

Further, embodiments may include the location interface module 45726, which is initiated by the location ID module 45724 when a location identifier is detected. The location interface module 45726 receives the location identifier from the location ID module 45724 and extracts parameters from the location interface database 45728. The parameters extracted are then displayed on the mobile device 45708 user interface, which allows the wagering app 45710 to have a customized interface based on the mobile device 45708 location. The location interface module 45726 provides a list of available devices that the user may take control of through their mobile device 45708, and the user may or may not select one of the available devices to take control of. Then the location interface module 45726 is continuously polling for the user to select a wager. If it is determined that the user selected a wager, then the wager module (not shown) is initiated. If it is determined that the user did not select a wager, or after the location interface module 45726 initiates the wager module (not shown), the location interface module 45726 determines if the mobile device 45708 is still at the location. If it is determined that the mobile device 45708 is still located at the same location, then the process returns to polling for a wager selection by the user; however, it if is determined that the mobile device 45708 is no longer at the location, the location interface module 45726 displays the default user interface on the wagering app 45710.

Further, embodiments may include the location interface database 45728, which stores the location-specific interfaces and the corresponding settings used by the location ID module 45724 to determine a location of a mobile device 45708, and by the location interface module 45726 to extract the interface parameters through a data file stored in the location interface database 45728 to display an interface customized for the location on the mobile device 45708 interface. The location interface database 45728 may contain the location, such as a sports stadium, restaurant, or bar, an identifier, such as a unique combination of numbers, letters, or characters that may be used to identify a specific location, the address of the location, the GPS coordinates of the location, an interface data file which contains the unique interface to the location, and a list of available devices that the user may control through the mobile device 45708 such as televisions, tablets, or gaming machines. In some embodiments, the location interface database 45728 may contain additional features or functions specific to the location, for example, ordering food or beverages through the interface, providing images specific to the location, offering promotions or coupons specific to the location, etc.

FIG. 458 illustrates the location ID module 45724. The process begins with the location ID module 45724 being executed, at step 45800, upon the mobile device 45708 connecting to the wagering network 45714. For example, a user activates the wagering app 45710 on the mobile device 45708, and the mobile device 45708 connects to the wagering network 45714, which executes the location ID module 45724 to determine the user's location. The location ID module 45724 is continuously polling, at step 45802, for the sensor data from the mobile device 45708, for example, the location ID module 45724 is polling for sensor data, such as GPS data from the mobile device 45708, the Wi-Fi the mobile device 45708 is currently connected to, an image from the mobile device 45708 such as an image inside a stadium or arena, recorded microphone data from the mobile device 45708, such as an announcement or broadcast through the public announcements in a stadium or arena, or geofence location data, to determine the physical location of the mobile device 45708. Then the location ID module 45724 receives, at step 45804, the sensor data from the mobile device 45708, for example, the location ID module 45724 is polling for sensor data, such as GPS data from the mobile device 108, the Wi-Fi the mobile device 45708 is currently connected to, an image from the mobile device 45708 such as an image inside a stadium or arena, recorded microphone data from the mobile device 45708, such as an announcement or broadcast through the public announcements in a stadium or arena, or geofence location data, to determine the physical location of the mobile device 45708. The location ID module 45724 then compares, at step 45806, the received sensor data to the location interface database 45728. For example, if the received sensor data is GPS coordinates from the mobile device, the location ID module 45724 compares the received GPS coordinates to the GPS coordinates stored in the location interface database 45728 to determine if there is a match. In some embodiments, the received sensor data may be a Wi-Fi connection or name, an image from inside a stadium, arena, restaurant, or bar, a sound clip or audio recording captured by the microphone in the mobile device 45708 of a broadcast within an arena or stadium, etc. For example, if a user is located at Fenway Park in Boston, MA, the mobile device 45708 may send GPS coordinates, such as 42.34676, −71.09720, to the location ID module 45724, which is then compared to the GPS coordinates stored in the location interface database 45728. The location ID module 45724 determines, at step 45808, if there is a match between the received sensor data and the data stored in the location interface database 45728. For example, if the received GPS coordinates from the mobile device 45708 are 42.34676, −71.09720 and these coordinates are stored in the location interface database 45728, then the wagering network 45714 knows that the user is located at Fenway Park in Boston, MA. If it is determined that there is a match between the received sensor data and the data stored in the location interface database 45728, the location ID module 45724 extracts and sends, at step 45810, the identifier stored in the location interface database 45728 to the location interface module 45726. For example, if the match determines the user is located at Fenway Park in Boston, MA, the identifier associated with Fenway Park may be #457123, extracted from the location interface database 45728 sent to the location interface module 45726. Then the location ID module 45724 initiates, at step 45812, the location interface module 45726. If it is determined that there is no match between the received sensor data from the mobile device 45708 and the data stored in the location interface database 45728, then the location ID module 45724 displays, at step 45814, the default user interface for the wagering app 45710 on the user's mobile device 45708.

FIG. 459 illustrates the location interface module 45726. The process begins with the location interface module 45726 being initiated, at step 45900, by the location ID module 45724. For example, if it is determined that there is a match between the received sensor data from the mobile device 45708 and the location interface database 45728, the location ID module 45724 initiates the location interface module 45726. Then the location interface module 45726 receives, at step 45902, the identifier from the location ID module 45724. For example, if it was determined there was a match between the received sensor data from the mobile device 108 and the location interface database 45728, the location ID module 45724 extracts the associated identifier with that location. If it is determined that the mobile device 45708 is located at Fenway Park in Boston, MA, the associated identifier of #457123 is extracted from the location interface database 45728 and is sent by the location ID module 45724 and received by the location interface module 45726. The location interface module 45726 compares, at step 45904, the received identifier to the location interface database 45728 to find the associated data stored with the identifier. For example, suppose the received identifier is #457123. In that case, the associated data with that identifier may be the location, such as Fenway Park, the address such as 4 Jersey St., Boston, MA, and the interface data file, which contains the customized interface for the wagering app 45710 that provides the user with a unique experience through a customized interface based upon their location. Then the location interface module 45726 extracts, at step 45906, the interface parameters from the location interface database 45728 associated with the received identifier. For example, if the received identifier is #457123, the associated interface parameters are stored in the data file FenwayPark. Data, which provides the user with a unique experience through the wagering app 45710 through a customized interface based upon their location. In this example, the wagering app 45710 may have an interface with the Boston Red Sox team colors and may connect the wagering app 45710 to a 3rd party network that allows the user to order food and beverages through the wagering app 45710. Then the location interface module 45726 displays, at step 45908, the interface on the wagering app 45710. For example, if the received identifier is #457123, the associated interface parameters are stored in the data file FenwayPark. Data, which provides the user with a unique experience through the wagering app 45710 through a customized interface based upon their location. In this example, the wagering app 45710 may have an interface with the Boston Red Sox team colors and may connect the wagering app 45710 to a 3rd party network that allows the user to order food and beverages through the wagering app 45710. The location interface module 45726 provides, at step 45910, the user with a list of available devices. For example, the available devices are extracted from the location interface database 45728, which allows a user to connect the mobile device 45708 to the available device and take control of the device from their mobile device 45708, such as a television in a restaurant, a tablet in which food and beverages may be ordered through at a stadium or arena, or a gaming machine at a bar such as a state-run lottery game, for example, Keno, All or Nothing, Powerball, Mega Millions, or a sports wagering machine, etc. to allow the user to place wagers, purchase tickets through their mobile device 45708 on the gaming machine. The location interface module 45726 determines, at step 45912, if the user selected an available device to control. For example, the location interface module 45726 provides a list of available devices, such as televisions, tablets, gaming machines, etc., to the user within the stadium, arena, restaurant, or bar for the user to control, and the user may select one of the available devices to control. In some embodiments, the available devices to the user may depend on the location of the mobile device within the stadium, arena, restaurant, or bar so that the devices located nearest to the mobile device 45708 may appear at the top of the list of available devices. In some embodiments, the user may control the device through a Bluetooth connection, Wi-Fi connection, or the cloud 45706, providing the user the ability to control the device through the mobile device 45708. In some embodiments, the user may have control of various functions of the device. For example, the user may control the channels, volume, etc., on a television, the ability to order food, beverages, pay a bill, etc., through a tablet, place wagers, or purchase tickets for gaming machines. If it is determined that the user selected an available device, the location interface module 45726 allows, at step 45914, permission to the user to control the device. For example, the user may have control of various functions of the device. For example, the user may control the channels, volume, etc., on a television, the ability to order food, beverages, pay a bill, etc., through a tablet, place wagers, or purchase tickets for gaming machines. If it is determined that the user did not select an available device to control or after the user has selected an available device to control, the location interface module 45726 continuously polls, at step 45916, for a wager selection from the user. The new interface provides the same wagering functionality provided by the wagering app 45710, and the location interface module 45726 is waiting for the user to select a wager. The location interface module 45726 determines, at step 45918, if the user selected a wager through the wagering app 45710. If it is determined that the user has selected a wager, then the location interface module 45726 initiates, at step 45920, the wagering module, which allows the user to place their wager through the wagering network 45714. If it is determined that the user did not select a wager, then it is determined, at step 45922, if the mobile device is still at the location. If it is determined that the user is still at the location, then the process returns to step 45916. In some embodiments, if the user does not select a wager in a predetermined amount of time, for example, 5 minutes, then the process returns to the location ID module 45724 to determine the location of the mobile device 45708 by receiving the sensor data and comparing the data to the location interface database 45728 to find a match, extracts the identifier and sends the identifier to the location interface module 45726 to ensure that the user's mobile device 45708 is still located at the same location. If it is determined that the user's mobile device 45708 is no longer at the location, then the location interface module 45726 displays, at step 45924, the default interface of the wagering app 45710. In some embodiments, if the user does not select a wager in a predetermined amount of time, for example, 5 minutes, then the process returns to the location ID module 45724 to determine the location of the mobile device 45708 by receiving the sensor data and comparing the data to the location interface database 45728. If a match between the received sensor data and the location interface database 45728 is not found, the location ID module 45724 displays the default interface of the wagering app 45710 and disconnects the user's mobile device 45708 from any devices within the arena, stadium, restaurant, or bar that they may have previously connected to.

FIG. 460 illustrates the location interface database 45728, which stores the location-specific interfaces and the corresponding settings used by the location ID module 45724 to determine the location of the mobile device 45708, and uses the location interface module 45726 to extract the interface parameters through a data file stored in the location interface database 45728 to display an interface customized for the location on the mobile device 45708. The location interface database 45728 may contain the location, such as a sports stadium, restaurant, or bar, an identifier, such as a unique combination of numbers, letters, or characters that are used to identify a specific location, the address of the location, the GPS coordinates or geofence location data of the location, and an interface data file which contains the unique interface to the location. In some embodiments, the location interface database 45728 may contain additional features or functions specific to the location, for example, ordering food or beverages through the interface, providing images specific to the location, offering promotions or coupons specific to the location, etc. The data file may be unique to each individual location to provide the user with an interface that is based on the home team colors, include logos, etc. and for restaurants and bars, provide the locations colors, branding, logos, advertisements, promotions such as two-dollar beers or fifty percent off appetizers. In some embodiments, the data file may provide the wagering app 45710 with access to a 3rd party device, server, or service, receive food and beverage menus, and allow the user through the wagering app 45710 to send in food and beverage orders to the 3rd party.

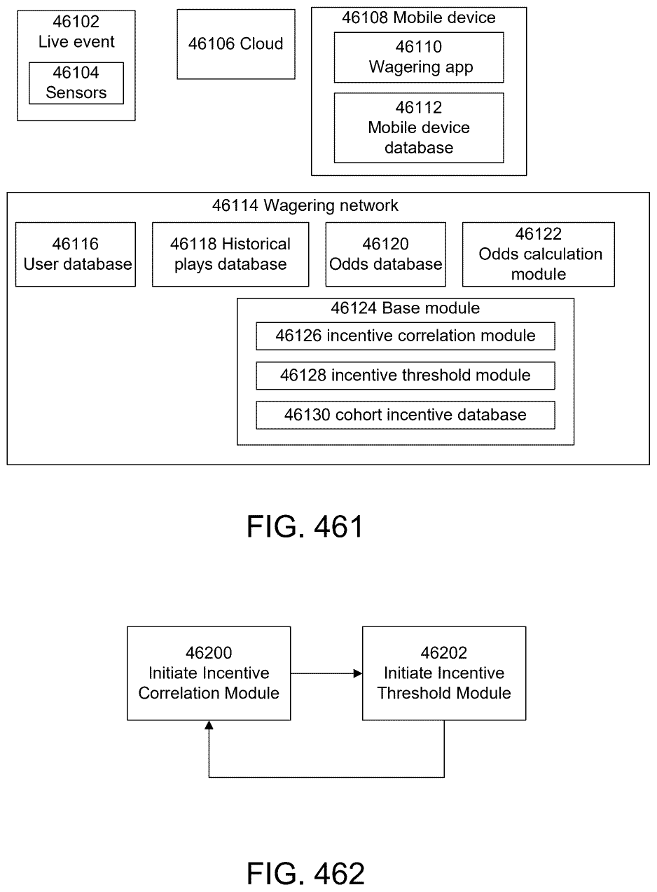

FIG. 461 illustrates a system for increasing user engagement by offering incentives to incrementally modify user behavior, according to an embodiment.

FIG. 462 illustrates a base module, according to an embodiment.

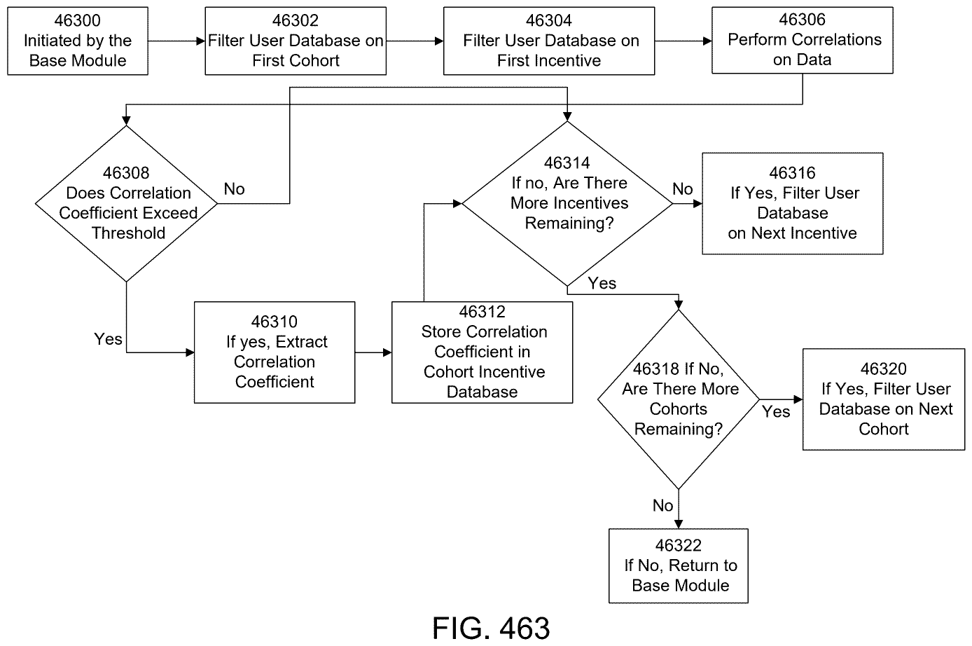

FIG. 463 illustrates an incentive correlation module, according to an embodiment.

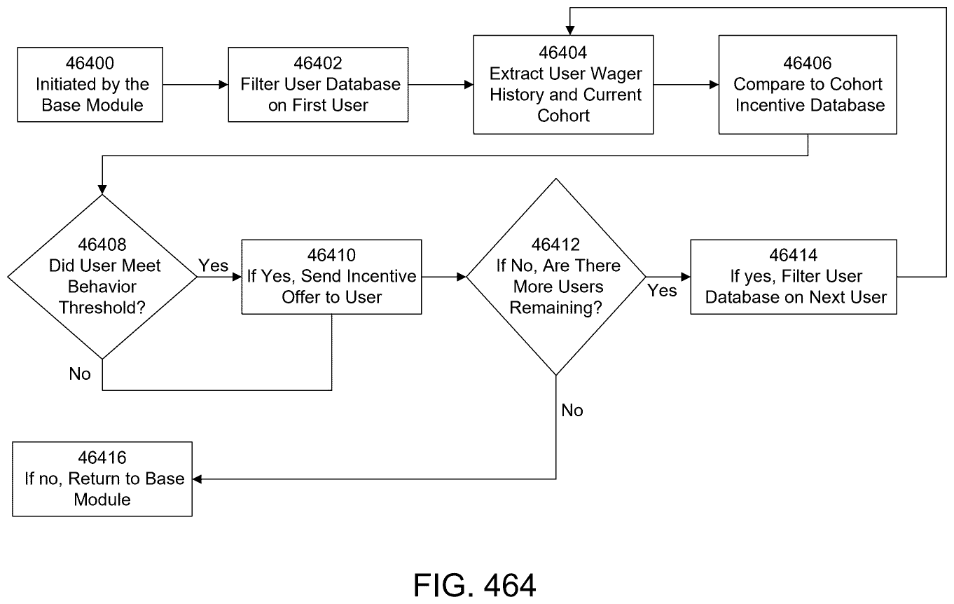

FIG. 464 illustrates an incentive threshold module, according to an embodiment.

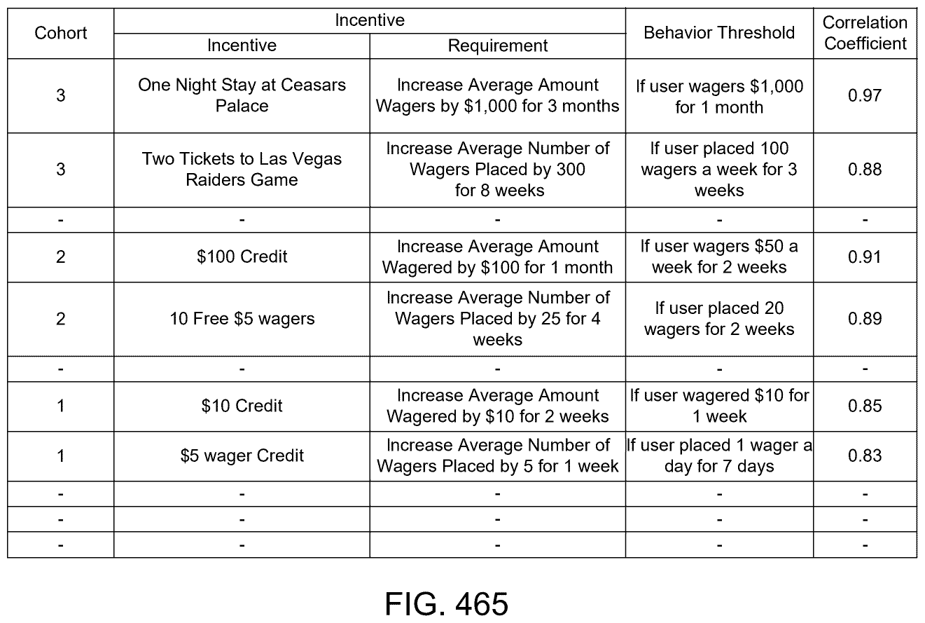

FIG. 465 illustrates a cohort incentive database, according to an embodiment.

FIG. 461 displays a system for increasing user engagement by offering incentives to incrementally modify user behavior. This system may include a live event 46102, for example, a sporting event such as a football, basketball, baseball, or hockey game, tennis match, golf tournament, eSports or digital game, etc. The live event 46102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 46102, such as the score of an American football game or the run line in a baseball game, or a series of actions in the live event 46102. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 46102 or at another location.

Further, embodiments may include a plurality of sensors 46104 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 46104 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 46106 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 46106 may be communicatively coupled to a peer-to-peer wagering network 46114, which may perform real-time analysis on the type of play and the result of the play. The cloud 46106 may also be synchronized with game situational data such as the time of the game, the score, location on the field, weather conditions, and the like, which may affect the choice of play utilized. For example, in an exemplary embodiment, the cloud 46106 may not receive data gathered from the sensors 46104 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 46108 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 108 could be an optional component and would be utilized in a situation where a paired wearable device employs the mobile device 46108 for additional memory or computing power or connection to the internet.

Further, embodiments may include a wagering software application or a wagering app 46110, which is a program that enables the user to place bets on individual plays in the live event 46102, streams audio and video from the live event 46102, and features the available wagers from the live event 46102 on the mobile device 46108. The wagering app 46110 allows the user to interact with the wagering network 46114 to place bets and provide payment/receive funds based on wager outcomes.

Further, embodiments may include a mobile device database 46112 that may store some or all the user's data, the live event 46102, or the user's interaction with the wagering network 46114.

Further, embodiments may include the wagering network 46114, which may perform real-time analysis on the type of play and the result of a play or action. The wagering network 46114 (or the cloud 46106) may also be synchronized with game situational data, such as the time of the game, the score, location on the field, weather conditions, and the like, which may affect the choice of play utilized. For example, in an exemplary embodiment, the wagering network 46114 may not receive data gathered from the sensors 46104 and may, instead, receive data from an alternative data feed, such as SportsRadar®. This data may be provided substantially immediately following the completion of any play, and may be compared with a variety of team data and league data based on a variety of elements, including the current down, possession, score, time, team, and so forth, as described in various exemplary embodiments herein. The wagering network 46114 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 46116, which may contain data relevant to all users of the wagering network 46114 and may include, but is not limited to, a user ID, a device identifier, a paired device identifier, wagering history, or wallet information for the user. The user database 46116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 46116 may contain betting lines and search queries. The user database 46116 may be searched based on a search criterion received from the user. Each betting line may include, but is not limited to, a plurality of betting attributes such as at least one of the live event 46102, a team, a player, an amount of wager, etc. The user database 46116 may include, but is not limited to, information related to all the users involved in the live event 46102. In one exemplary embodiment, the user database 46116 may include information for generating a user authenticity report and a wagering verification report. Further, the user database 46116 may be used to store user statistics like, but not limited to, the retention period for a particular user, frequency of wagers placed by a particular user, the average amount of wager placed by each user, etc.

Further, embodiments may include a historical plays database 46118 that may contain play data for the type of sport being played in the live event 46102. For example, in American Football, for optimal odds calculation, the historical play data may include metadata about the historical plays, such as time, location, weather, previous plays, opponent, physiological data, etc.

Further, embodiments may utilize an odds database 46120—that contains the odds calculated by an odds calculation module 46122—to display the odds on the user's mobile device 46108 and take bets from the user through the mobile device wagering app 46110.

Further, embodiments may include the odds calculation module 46122, which utilizes historical play data to calculate odds for in-play wagers.

Further, embodiments may include a base module 46124, which initiates an incentive correlation module 46126, which determines the appropriate incentives that should be offered to the users and initiates an incentive threshold module 46128, which determines if the user's wagering history behavior results in being offered an incentive and incentive requirements that the user would need to reach to receive the incentive.

Further, embodiments may include the incentive correlation module 46126, which filters the user database 46116 on the first cohort. Then the incentive correlation module 46126 filters the user database 46116 on the first incentive. The incentive correlation module 46126 performs correlations on the filtered data. For example, the user database 46116 is filtered on the cohort, and one of the incentives, such as $100 credit or one-night stay at Caesars Palace, and then correlations are performed on the rest of the parameters with the selected parameter that has filtered the database, such as length of time since the user has been offered the incentive against the user's wagering history. An example of correlated parameters is with the time since the user being offered a one-night stay at Caesars Palace vs. the number of wagers placed by the user with a 0.97 correlation coefficient, and this correlation is extracted and stored in a cohort incentive database 46130 with the cohort, such as cohort three, and the incentive, such as one night stay in Caesars Palace. Another example, the user database 46116 is filtered on the cohort and one of the incentives, such as $100 credit. An example of correlated parameters is with the time since the user was offered the incentive of a $100 credit vs. the number of wagers placed by the user with a 0.91 correlation coefficient, and this correlation is extracted and stored in the cohort incentive database 46130 with the cohort, such as cohort two, and the incentive, such as the $100 credit. An additional example may be, the user database 46116 is filtered on the cohort and one of the incentives, such as a $10 credit. An example of correlated parameters is the amount of time since the user was offered the $10 credit incentive vs. the number of wagers placed by the user with a 0.85 correlation coefficient, and this correlation is extracted and stored in the cohort incentive database 46130. These examples provide the wagering network with incentives that increase user engagement to achieve the offered incentive. For example, if the user is offered one night at Caesars Palace, the correlation coefficient of 0.97 shows that the user has increased the number of wagers placed within a certain time to receive the offered incentive. Then the incentive correlation module 46126 extracts the correlation coefficient from the correlations that were performed and stores the correlation coefficient, the incentive, and the cohort in the cohort incentive database 46130. If it is determined that more incentives are remaining in the user database 46116, the incentive correlation module 46126 filters the user database 46116 on the next incentive, and the process returns performing correlations. If it is determined that there are no more incentives remaining in the user database 46116, the incentive correlation module 46126 determines if more cohorts are remaining in the user database 46116. If it is determined that more cohorts are remaining in the user database 46116, the incentive correlation module 46126 filters the user database 46116 on the next cohort and returns filtering the user database 46116 on the incentives. If it is determined that there are no more cohorts remaining, the incentive correlation module 46126 returns to the base module 46124.

Further, embodiments may include the incentive threshold module 46128, which filters the user database 46116 on the first user. Then the incentive threshold module 46128 extracts the user wager history and current cohort from the user database 46116. The incentive threshold module 46128 then compares the user wager history to the cohort incentive database 46130 behavior threshold. Then the incentive threshold module 46128 determines if the user meets any of the behavior thresholds. For example, if the user's cohort is cohort one and the user has wagered $10 for one week, the user will be offered an incentive for a $10 credit if the user increases the average amount wagered by $10 for two weeks. Another example would be if the user is in cohort two and if the user reaches the behavior threshold of wagering $50 a week for two weeks, then the user will be offered an incentive of $100 credit if the user increases the average amount wagered by $100 for one month. If it is determined that the user did meet the behavior threshold, the incentive threshold module 46128 sends the incentive to the user. If it is determined that the user did not meet the threshold requirements, the incentive threshold module determines if more users are remaining in the user database 46116. If it is determined that more users are remaining in the user database 46116, the incentive threshold module 46128 filters the user database 46116 on the next user, and the process returns extracting the user's wagering history. If it is determined that there are no more users remaining in the user database 46116, the incentive threshold module 46128 returns to the base module 46124.

Further, embodiments may include a cohort incentive database 46130, which contains the cohort, such as 3 for expert, 2 for casual, 1 for a beginner. It may also contain the incentives that have been associated with each cohort, such as what the incentive is and the requirement to secure the incentive, the behavior threshold, and the correlation coefficient. For example, the cohort incentive database 46130 contains the correlation coefficient from the process described in the incentive correlation module 46126 to determine if the incentive provided increases user engagement. For example, the incentive is correlated with increasing the wagers placed or the amount wagered over a certain time after collecting the incentive. The behavior threshold is used in the process described in the incentive threshold module 46128 to determine if the user's previous wagering pattern matches the behavior to be offered the chance to win the incentive, in which the user needs to meet incentive requirements to receive the incentive.

FIG. 462 illustrates the base module 46124. The process begins with the base module 46124 initiating, at step 46200, the incentive correlation module 46126. In an exemplary embodiment, the base module 46124 is always running. In one embodiment, the base module may be prompted by hew data in the user database 46116. The incentive correlation module 46126 filters the user database 46116 on the first cohort. Then the incentive correlation module 46126 filters the user database 46116 on the first incentive. The incentive correlation module 46126 performs correlations on the filtered data. For example, the user database 46116 is filtered on the cohort, and one of the incentives, such as $100 credit or one-night stay at Caesars Palace, and then correlations are performed on the rest of the parameters with the selected parameter that has filtered the database, such as length of time since the user has been offered the incentive against the user's wagering history. An example of correlated parameters is the time since the user being offered a one-night stay at Caesars Palace vs. the number of wagers placed by the user with a 0.97 correlation coefficient, this correlation is extracted and stored in the cohort incentive database 46130 with the cohort, such as cohort 3, and the incentive, such as one night stay in Caesars Palace. Another example, the user database 46116 is filtered on the cohort and one of the incentives, such as $100 credit. An example of correlated parameters is with the time since the user was offered the incentive of a $100 credit vs. the number of wagers placed by the user with a 0.91 correlation coefficient, and this correlation is extracted and stored in the cohort incentive database 46130 with the cohort, such as 2, and the incentive, such as the $100 credit. An additional example may be, the user database 46116 is filtered on the cohort and one of the incentives, such as a $10 credit. An example of correlated parameters is the amount of time since the user was offered the $10 credit incentive vs. the number of wagers placed by the user with a 0.85 correlation coefficient, this correlation is extracted and stored in the cohort incentive database 46130. These examples provide the wagering network with incentives that increase user engagement to achieve the offered incentive. For example, if the user is offered one night at Caesars Palace, the correlation coefficient of 0.97 shows that the user has increased the number of wagers placed within a certain time to receive the offered incentive. Then the incentive correlation module 46126 extracts the correlation coefficient from the correlations that were performed and stores the correlation coefficient, the incentive, and the cohort in the cohort incentive database 46130. If it is determined that more incentives are remaining in the user database 46116, the incentive correlation module 46126 filters the user database 46116 on the next incentive, and the process returns performing correlations. If it is determined that there are no more incentives remaining in the user database 46116, the incentive correlation module 46126 determines if more cohorts are remaining in the user database 46116. If it is determined that more cohorts are remaining in the user database 46116, the incentive correlation module 46126 filters the user database 46116 on the next cohort and returns filtering the user database 46116 on the incentives. If it is determined that there are no more cohorts remaining, the incentive correlation module 46126 returns to the base module 46124. Then the base module 46124 initiates, at step 46202, the incentive threshold module 46128. For example, the incentive threshold module 46128 filters the user database 46116 on the first user. Then the incentive threshold module 46128 extracts the user wager history and current cohort from the user database 46116. The incentive threshold module 46128 then compares the user wager history to the cohort incentive database 46130 behavior threshold. Then the incentive threshold module 46128 determines if the user meets any of the behavior thresholds. For example, if the user's cohort is cohort one and the user has wagered $10 for one week, the user will be offered an incentive for a $10 credit if the user increases the average amount wagered by $10 for two weeks. Another example would be if the user is in cohort two and if the user reaches the behavior threshold of wagering $50 a week for two weeks, then the user will be offered an incentive of $100 credit if the user increases the average amount wagered by $100 for one month. If it is determined that the user did meet the behavior threshold, the incentive threshold module 46128 sends the incentive to the user. If it is determined that the user did not meet the threshold requirements, the incentive threshold module determines if more users are remaining in the user database 46116. If it is determined that more users are remaining in the user database 46116, the incentive threshold module 46128 filters the user database 46116 on the next user, and the process returns extracting the user's wagering history. If it is determined that there are no more users remaining in the user database 46116, the incentive threshold module 46128 returns to the base module 46124.

FIG. 463 illustrates the incentive correlation module 46126. The process begins with the base module 46124 initiating, at step 46300, the incentive correlation module 46126. The incentive correlation module 46126 filters, at step 46302, the user database 46116 on the first cohort. For example, the user database 46116 may contain the user's cohort, such as cohort 1 for a beginner user, cohort 2 for a casual gambler, and cohort 3 for an expert gambler, the incentives previously offered to the user, such as a $100 credit or one night stay at Caesars Palace, the date in which the incentive was offered, and the user's wagering history. Then the incentive correlation module 46126 filters, at step 46304, the user database 46116 on the first incentive. For example, the incentive correlation module 46126 filters the database on the first incentive, such as $100 credit or a one-night stay at Caesars Palace. The incentive correlation module 46126 performs, at step 46306, correlations on the filtered data. For example, the user database 46116 is filtered on the cohort, and one of the incentives, such as $100 credit or one-night stay at Caesars Palace and then correlations are performed on the rest of the parameters with the selected parameter that has filtered the database, such as length of time since the user has been offered the incentive against the user's wagering history. An example of correlated parameters is the time since the user being offered a one-night stay at Caesars Palace vs. the number of wagers placed by the user with a 0.97 correlation coefficient, and this correlation is extracted and stored in the cohort incentive database 46130 with the cohort, such as cohort three, and the incentive, such as one night stay in Caesars Palace. In another example, the user database 46116 is filtered on the cohort and one of the incentives, such as $100 credit. An example of correlated parameters is the time since the user was offered the incentive of a $100 credit vs. the number of wagers placed by the user with a 0.91 correlation coefficient, and this correlation is extracted and stored in the cohort incentive database 46130 with the cohort, such as cohort two, and the incentive, such as the $100 credit. An additional example may be, the user database 46116 is filtered on the cohort and one of the incentives, such as a $10 credit. An example of correlated parameters is the amount of time since the user was offered the $10 credit incentive vs. the number of wagers placed by the user with a 0.85 correlation coefficient, and this correlation is extracted and stored in the cohort incentive database 46130. These examples provide the wagering network 46114 with incentives that increase user engagement to achieve the offered incentive. For example, if the user is offered one night at Caesars Palace, the correlation coefficient of 0.97 shows that the user has increased the number of wagers placed within a certain time to receive the offered incentive. The incentive correlation module 46126 determines, at step 46308, if the correlation coefficient exceeds a predetermined threshold. For example, if the correlation coefficient is above a 0.75 correlation coefficient threshold, that would determine if the incentive provided to the user increased the user's engagement and the incentive provided the desired effect to increase the user's wagering habits. If the correlation coefficient is below the threshold, that may result in the incentive not providing the necessary reaction from users to increase engagement, and the incentive would not be provided to users. If it is determined that the correlation coefficient exceeded the predetermined threshold, then the incentive correlation module 46126 extracts, at step 46310, the correlation coefficient from the correlations that were performed. For example, if the two correlated parameters are the time since the user being offered a one-night stay at Caesars Palace and the number of wagers placed by the user with a 0.97 correlation coefficient and this correlation is extracted. Then the incentive correlation module 46126 stores, at step 46312, the correlation coefficient in the cohort incentive database 46130. For example, the incentive correlation module 46126 stores the correlation coefficient of 0.97. If it is determined that the correlation coefficient is not above the predetermined threshold, the incentive correlation module 46126 determines, at step 46314, if more incentives are remaining in the user database 46116. In some embodiments, the incentive may be removed from the cohort incentive database 46130 if the correlation coefficient does not exceed the predetermined threshold. If it is determined that more incentives are remaining in the user database 46116, the incentive correlation module 46126 filters, at step 46316, the user database 46116 on the next incentive, and the process returns to step 46306. For example, if the user database 46116 is filtered for cohort three, the next incentive might be two free tickets to a Las Vegas Raiders Football game. The user database 46116 may then be filtered on the next incentive, and correlations are performed. If it is determined that there are no more incentives remaining in the user database 46116, the incentive correlation module 46126 determines, at step 46318, if more cohorts are remaining in the user database 46116. For example, if there are no more incentives for cohort three, then the incentive correlation module 46126 filters the user database 46116 on the next cohort, such as cohort two. If it is determined that more cohorts are remaining in the user database 46116, the incentive correlation module 46126 filters, at step 46320, the user database 46116 on the next cohort and returns to step 46304. If it is determined that there are no more cohorts remaining, the incentive correlation module 46126 returns, at step 46322, to the base module 46124.

FIG. 464 illustrates the incentive threshold module 46128. The process begins with the incentive threshold module 46128 being initiated, at step 46400, by the base module 46124. The incentive threshold module 46128 filters, at step 46402, the user database 46116 on the first user. For example, the incentive threshold module 46128 filters the user database 46116 on the user ID, such as JS12345. Then the incentive threshold module 46128 extracts, at step 46404, the user wager history and current cohort from the user database 46116. For example, the incentive threshold module 46128 extracts all the wagers previously placed by the user. In some embodiments, the extracted wagering history may be for the past hour, day, week, month, year, etc. The incentive threshold module 46128 then compares, at step 46406, the user wager history to the cohort incentive database 46130 behavior threshold. For example, if the user's cohort is cohort one and the user has wagered $10 for one week, the user will be offered an incentive for a $10 credit if the user increases the average amount wagered by $10 for two weeks. Another example would be if the user is in cohort two and if the user reaches the behavior threshold of wagering $50 a week for two weeks, then the user will be offered an incentive of $100 credit if the user increases the average amount wagered by $100 for one month. Then the incentive threshold module 46128 determines, at step 46408, if the user meets any of the behavior thresholds. For example, if the user's cohort is cohort one and the user has wagered $10 for one week, the user will be offered an incentive for a $10 credit if the user increases the average amount wagered by $10 for two weeks. Another example would be if the user is in cohort two and if the user reaches the behavior threshold of wagering $50 a week for two weeks, then the user will be offered an incentive of $100 credit if the user increases the average amount wagered by $100 for one month. If it is determined that the user did meet the behavior threshold, the incentive threshold module 46128 sends, at step 46410, the incentive to the user. For example, if the user's cohort is cohort one and the user has wagered $10 for one week, the user will be offered an incentive for a $10 credit if the user increases the average amount wagered by $10 for two weeks. Another example would be if the user is in cohort two and if the user reaches the behavior threshold of wagering $50 a week for two weeks, then the user will be offered an incentive of $100 credit if the user increases the average amount wagered by $100 for one month. If it is determined that the user did not meet the threshold requirements, the incentive threshold module 46128 determines, at step 46412, if more users are remaining in the user database 46116. If it is determined that more users are remaining in the user database 46116, the incentive threshold module 46128 filters, at step 46414, the user database 46116 on the next user, and the process returns to step 46304. If it is determined that there are no more users remaining in the user database 46116, the incentive threshold module 46128 returns, at step 46416, to the base module 46124.

FIG. 465 illustrates the cohort incentive database 46130. This figure displays the cohort incentive database 46130, which contains the cohort, such as cohort three for expert, cohort two for casual, or cohort one for beginner, the incentives, such as what the incentive is and the requirement to secure the incentive, the behavior threshold, and the correlation coefficient. For example, the cohort incentive database 46130 contains the correlation coefficient from the process described in the incentive correlation module 46126 to determine if the incentive provided increases user engagement, such as increasing the wagers placed or the amount wagered over a certain time to collect the incentive. The behavior threshold is used in the process described in the incentive threshold module 46128 to determine if the user's previous wagering pattern matches the behavior to be offered the chance to win the incentive, in which the user needs to meet incentive requirements to receive the incentive.

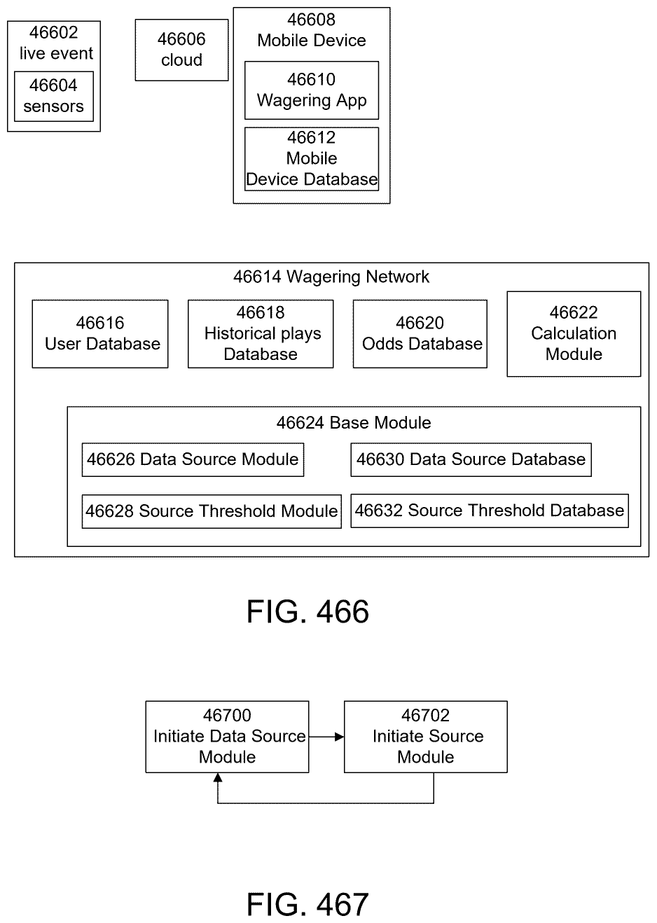

FIG. 466 illustrates a system for using multiple data types to calculate odds, according to an embodiment.

FIG. 467 illustrates a base module, according to an embodiment.

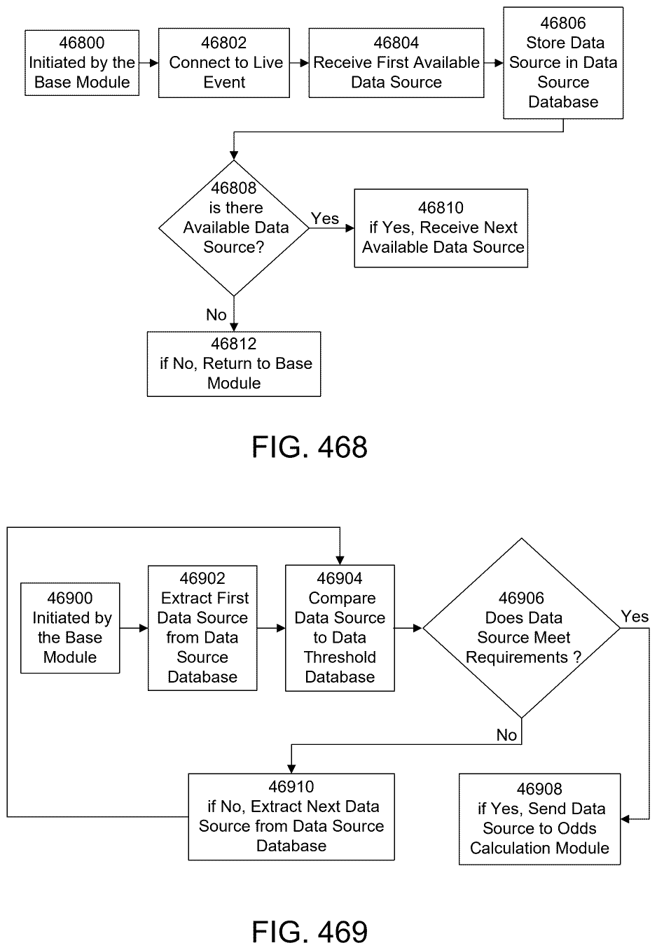

FIG. 468 illustrates a data source module, according to an embodiment.

FIG. 469 illustrates a source threshold module, according to an embodiment.

FIG. 470 illustrates a data source database, according to an embodiment.

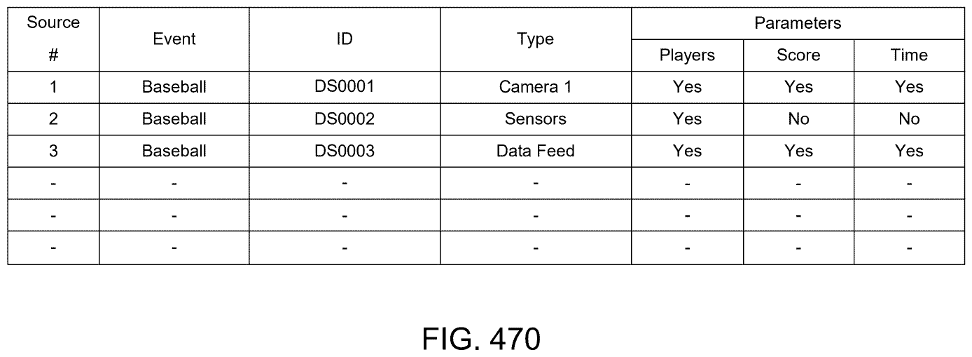

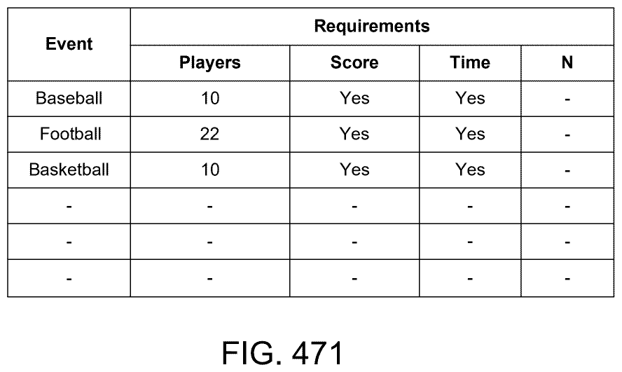

FIG. 471 illustrates a data threshold database, according to an embodiment.

FIG. 466 is a system for using multiple data types to calculate odds. This system may include a live event 46602, for example, a sporting event such as a football, basketball, baseball, or hockey game, tennis match, golf tournament, eSports, or digital game, etc. The live event 46602 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 46602, such as the score of an American football game or the run line in a baseball game, or a series of actions in the live event 46602. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 46602 or at another location.

Further, embodiments may include a plurality of sensors 46604 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 46604 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 46606 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 46606 may be communicatively coupled to a wagering network 46614, which may perform real-time analysis on the type of play and the result of the play. The cloud 46606 may also be synchronized with game situational data such as the time of the game, the score, location on the field, weather conditions, and the like, which may affect the choice of play utilized. For example, in an exemplary embodiment, the cloud 46606 may not receive data gathered from the sensors 46604 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 46608 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras

(SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 46608 could be an optional component and would be utilized in a situation where a paired wearable device employs the mobile device 46608 for additional memory or computing power or connection to the internet.

Further, embodiments may include a wagering software application or a wagering app 46610, which is a program that enables the user to place bets on individual plays in the live event 46602, streams audio and video from the live event 46602, and features the available wagers from the live event 46602 on the mobile device 46608. The wagering app 46610 allows the user to interact with the wagering network 46614 to place bets and provide payment/receive funds based on wager outcomes.

Further, embodiments may include a mobile device database 46612 that may store some or all the user's data, the live event 46602, or the user's interaction with the wagering network 46614.

Further, embodiments may include the wagering network 46614, which may perform real-time analysis on the type of play and the result of a play or action. The wagering network 46614 (or the cloud 46606) may also be synchronized with game situational data, such as the time of the game, the score, location on the field, weather conditions, and the like, which may affect the choice of play utilized. For example, in an exemplary embodiment, the wagering network 46614 may not receive data gathered from the sensors 46604 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 46614 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 46616, which may contain data relevant to all users of the wagering network 46614 and may include, but is not limited to, a user ID, a device identifier, a paired device identifier, wagering history, or wallet information for the user. The user database 46616 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 46616 may contain betting lines and search queries. The user database 46616 may be searched based on a search criterion received from the user. Each betting line may include but is not limited to, a plurality of betting attributes such as at least one of the following: the live event 46602, a team, a player, an amount of wager, etc. The user database 46616 may include, but is not limited to, information related to all the users involved in the live event 46602. In one exemplary embodiment, the user database 46616 may include information for generating a user authenticity report and a wagering verification report. Further, the user database 46616 may be used to store user statistics like, but not limited to, the retention period for a particular user, frequency of wagers placed by a particular user, the average amount of wager placed by each user, etc.

Further, embodiments may include a historical plays database 46618 that may contain play data for the type of sport being played in the live event 46602. For example, in American Football, for optimal odds calculation, the historical play data may include metadata about the historical plays, such as time, location, weather, previous plays, opponent, physiological data, etc.

Further, embodiments may utilize an odds database 46620—that may contain the odds calculated by an odds calculation module 46622—to display the odds on the user's mobile device 46608 and take bets from the user through the mobile device wagering app 46610.

Further, embodiments may include the odds calculation module 46622, which may utilize historical play data to calculate odds for in-play wagers.

Further, embodiments may include a base module 46624, which may initiate the data source module 46626 and the source threshold module 46628. The data source module 46626 may connect to the live event 46602. For example, the data source module 46626 may connect to the plurality of sensors 46604 available at the live event 46602. The data source module 46626 may receive the first available data source. Then the data source module 46626 may store the data source in the data source database 46630. The data source module may determine if there is another available data source from the live event 46602. If another data source is available, the data source module 46626 may receive the next available data source. If no other data sources are available, then the data source module 46626 may return to the base module 46624. The source threshold module 46628 may extract the first data source from the data source database 46630. The source threshold module 46628 may compare the extracted data source to the source threshold database 46632. The source threshold module 46628 may determine if the data source meets the requirements stored in the source threshold database 46632. If it is determined that the data source meets the requirements in the source threshold database 46632, then the source threshold module 46628 may send the data source to the odds calculation module 46622 to determine the odds for the upcoming event. If it is determined that the data source does not meet the requirements stored in the source threshold database 46632, then the source threshold module 46628 may extract the next data source from the data source database 46630.

Further, embodiments may include a data source module 46626. The process may begin with the data source module 46626 being initiated by the base module 46624. Then the data source module 46626 may connect to the live event 46602. For example, the data source module 46626 may connect to the plurality of sensors 46604 available at the live event 46602. The data source module 46626 may receive the first available data source. For example, the data source module 46626 may receive the data from the first available sensors 46604 located at the live event 46602. Then the data source module 46626 may store the data source in the data source database 46630. For example, the data source module 46626 may store the type of sources, such as a camera, sensor, data feed, or various other sensors 46604, the source number, the type of event from which the data source is located, and the various parameters of the data source, such as the number of players, the names of players, the score to the event, the time of the event, etc. The data source module 46626 may determine if there is another available data source from the live event 46602. For example, there may be a plurality of data sources at the live event 46602, such as multiple cameras, multiple sensors, multiple types of data feeds, video feeds, audio feeds, etc. If there is another data source, the data source module 46626 may receive the next available data source. If there are no other data sources available, then the data source module 46626 may return to the base module 46624.

Further, embodiments may include a source threshold module 46628, which may extract the first data source from the data source database 46630. For example, the source threshold module 46628 may extract a camera from the data source database 46630, which may contain the parameters of the number of players on the field, the score of the event, and the time of the event. The source threshold module 46628 may compare the extracted data source to the source threshold database 46632. For example, the source threshold module 46628 may compare the event from the data source to the event in the source threshold database 46632, such as baseball, and then compare the parameters of the extracted camera data source, such as the number of players on the field, the score of the event and the time of the event, to the requirements for a baseball event stored in source threshold database 46632, such as the data source is required to have ten players on the field for baseball or the data source is required to have the score and the time of the event. The source threshold module 46628 may determine if the data source meets the requirements stored in the source threshold database 46632. For example, assuming the extracted camera data source parameters meet the thresholds stored in the source threshold database 46632, the camera data source may be sent to the odds calculation module 46622 to determine the wager odds. Another example may be if the extracted data source did not meet the requirements, then the source threshold module 46628 may select the next data source stored in the data source database 46630 to determine if the next data source meets the thresholds stored in the source threshold database 46632. In some embodiments, a plurality or all the requirements may need to be reached or exceeded for the data source to be sent to the odds calculation module 46622. Only one requirement may need to be reached or exceeded in some embodiments for the data source to be sent to the odds calculation module 46622. If the data source meets the requirements in the source threshold database 46632, then the source threshold module 46628 may send the data source to the odds calculation module 46622 to determine the odds for the upcoming event. For example, the extracted camera data source stored in the data source database 46630 may be sent to the odds calculation module 46622 to be used as the data source to calculate the wager odds. There may be a plurality of data sources sent to the odds calculation module 46622 to calculate the wager odds in some embodiments. For example, a camera may be used to calculate the odds for the upcoming result of a pitch, such as a strike or a ball, and data feed may be used to determine the odds of the wager for the upcoming result of a hit such as a single, double, triple, home run, etc. If the data source does not meet the requirements stored in the source threshold database 46632, then the source threshold module 46628 may extract the next data source from the data source database 46630.

Further, embodiments may include a data source database 46630. The data source database 46630 may contain a list of available data sources from the live event 46602, including cameras, video feed, audio feed, sensors on the field, sensors on the players, sensors on the officials, referees, or umpire's data feed such as SportsRadar or Trackman. In some embodiments, the data sources may include a plurality of sensors that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. The data source database 130 may also contain a source number, the event for which the data source is collecting data, a source identification (ID), the type of data source, and various parameters that list the details of what the data source provides. In some embodiments, the parameters may be the players are in the live event 46602, how many players are currently involved in an upcoming play, the score of the live event 46602, the time in the live event 46602, actions performed in the live event 46602, for example in baseball, a type of pitch thrown, the location of the pitch, if the pitch was a ball or strike, a hit such as a single, double, etc., a stolen base, etc. In some embodiments, the data source database 46630 may include the wagering market associated with the parameter. For example, if the parameter is for hits in a baseball game, then the associated wager market may be the odds for the batter to hit a single, double, triple, home run, etc. Another example may if the parameter is for the pitches thrown and the resulting outcome such as a strike or ball, then the associated wager market may be for the odds on the results of a pitch.

Further, embodiments may include a source threshold database 46632. The source threshold database 46632 may contain a list of thresholds that the available data sources stored in the data source database 46630 may be compared to during the process described in the source threshold module 46628. The source threshold database 46632 may contain the type of event, such as baseball, football, basketball, hockey, etc., and the requirements for the data source such as the number of players in the field of play, the names of players, the score of the event, the time in the event, and “N” representing an infinite number of potential requirements. In some embodiments, the requirements may include cameras, video feed, audio feed, sensors on the field, sensors on the players, sensors on the officials, referees, or umpires, a data feed such as SportsRadar or Trackman. In some embodiments, the requirements may include a plurality of sensors such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. In some embodiments, a plurality or all of the requirements may need to be reached or exceeded for the data source to be sent to the odds calculation module 46622. Only one requirement may need to be reached or exceeded in some embodiments for the data source to be sent to the odds calculation module 46622. In some embodiments, the requirements may be based on a specific wager market. For example, if the wagering market is for the outcome of a hit in a baseball game, such as single, double, triple, home run, etc., then the data source may only be required to have the data for the result of a hit. Another example may be if the wagering market is for the outcome of a pitch, such as a strike or a ball, then the data source may only be required to contain the outcome of a pitch.

FIG. 467 illustrates the base module 46624. The process may begin with the base module 46624 initiating, at step 46700, the data source module 46626. For example, the data source module 46626 may connect to the live event 46702. For example, the data source module 46626 may connect to the plurality of sensors 46604 available at the live event 46602. The data source module 46626 may receive the first available data source. For example, the data source module 46626 may receive the data from the first available sensor 46604 located at the live event 46602. Then the data source module 46626 may store the data source in the data source database 46630. For example, the data source module 46626 may store the type of sources, such as a camera, sensor, data feed, or various other sensors 46604, the source number, the type of event that the data source is located at, and the various parameters of the data source, such as the number of players, the names of players, the score to the event, the time of the event, etc. The data source module 46626 may determine if there is another available data source from the live event 46602. For example, there may be a plurality of data sources at the live event 46602, such as multiple cameras, multiple sensors, multiple types of data feeds, video feeds, audio feeds, etc. If there is another data source, the data source module 46626 may receive the next available data source. If there are no other data sources available, then the data source module 46626 may return to the base module 46624. Then the base module 46624 may initiate, at step 46602, the source threshold module 46628. For example, the source threshold module 46628 may extract the first data source from the data source database 46630. For example, the source threshold module 46628 may extract a camera from the data source database 46630, which may contain the parameters of the number of players on the field, the score of the event, and the time of the event. The source threshold module 46628 may compare the extracted data source to the data threshold database 46632. For example, the source threshold module 46628 may compare the event from the data source to the event in the data threshold database 46632, such as baseball, and then compare the parameters of the extracted camera data source, such as the number of players on the field, the score of the event and the time of the event, to the requirements for a baseball event stored in data threshold database 46632, such as the data source is required to have ten players on the field for baseball or the data source is required to have the score and the time of the event. The source threshold module 46628 may determine if the data source meets the requirements stored in the data threshold database 46632. For example, assuming the extracted camera data source parameters meet the thresholds stored in the data threshold database 46632, the camera data source may be sent to the odds calculation module 46622 to determine the wager odds. Another example may be if the extracted data source did not meet the requirements, then the source threshold module 46628 may select the next data source stored in the data source database 46630 to determine if the next data source meets the thresholds stored in the data threshold database 46632. In some embodiments, a plurality or all of the requirements may need to be reached or exceeded for the data source to be sent to the odds calculation module 46622. Only one requirement may need to be reached or exceeded in some embodiments for the data source to be sent to the odds calculation module 46622. If the data source meets the requirements in the source threshold database 46632, then the source threshold module 46628 may send the data source to the odds calculation module 46622 to determine the odds for the upcoming event. For example, the extracted camera data source stored in the data source database 46630 may be sent to the odds calculation module 46622 to be used as the data source to calculate the wager odds. There may be a plurality of data sources sent to the odds calculation module 46622 to calculate the wager odds in some embodiments. For example, a camera may be used to calculate the odds for the upcoming result of a pitch, such as a strike or a ball, and data feed may be used to determine the odds of the wager for the upcoming result of a hit such as a single, double, triple, home run, etc. If the data source does not meet the requirements stored in the source threshold database 46632, then the source threshold module 46628 may extract the next data source from the data source database 46630.

FIG. 468 illustrates the data source module 46626. The process may begin with the data source module 46626 being initiated, at step 46800, by the base module 46624. Then the data source module 46626 may connect, at step 46802, to the live event 46602. For example, the data source module 46626 may connect to the plurality of sensors 46604 available at the live event 46602. The data source module 46626 may receive, at step 46804, the first available data source. For example, the data source module 46626 may be receiving the data from the first available sensor 46604 located at the live event 46602. Then the data source module 46626 may store, at step 46806, the data source in the data source database 46630. For example, the data source module 46626 may store the type of sources, such as a camera, sensor, data feed, or various other sensors 46604, the source number, the type of event that the data source is located at, and the various parameters of the data source, such as the number of players, the names of players, the score to the event, the time of the event, etc. The data source module 46626 may determine, at step 46808, if another data source is available from the live event 46602. For example, there may be a plurality of data sources at the live event 46602, such as multiple cameras, multiple sensors, multiple types of data feeds, video feeds, audio feeds, etc. If there is another data source, the data source module 46626 may receive, at step 46810, the next available data source and return to step 46706. If there are no other data sources available, then the data source module 46626 may return, at step 46812, to the base module 46624.

FIG. 469 illustrates the source threshold module 46628. The process may begin with the source threshold module 46628 being initiated, at step 46900, by the base module 46624. Then the source threshold module 46628 may extract, at step 46902, the first data source from the data source database 46630. For example, the source threshold module 46628 may extract a camera from the data source database 46630, which may contain the parameters of the number of players on the field, the score of the event, and the time of the event. The source threshold module 46628 may compare, at step 46904, the extracted data source to the data threshold database 46632. For example, the source threshold module 46628 may compare the event from the data source to the event in the data threshold database 46632, such as baseball, and then may compare the parameters of the extracted camera data source, such as the number of players on the field, the score of the event and the time of the event, to the requirements for a baseball event stored in source threshold database 46632, such as the data source is required to have ten players on the field for baseball, the data source is required to have the score and the time of the event. The source threshold module 46628 may determine, at step 46906, if the data source meets the requirements stored in the source threshold database 46632. For example, assuming the extracted camera data source parameters meets the thresholds stored in the data threshold database 46632, the camera data source may be sent to the odds calculation module 46622 to be used to determine the wager odds. Another example may be if the extracted data source did not meet the requirements, then the source threshold module 46628 may select the next data source stored in the data source database 46630 to determine if the next data source meets the thresholds stored in the source threshold database 46632. In some embodiments, a plurality or all of the requirements may need to be reached or exceeded for the data source to be sent to the odds calculation module 46622. Only one requirement may need to be reached or exceeded in some embodiments for the data source to be sent to the odds calculation module 46622. If the data source meets the requirements in the source threshold database 46632, then the source threshold module 46628 may send, at step 46908, the data source to the odds calculation module 46622 to determine the odds for the upcoming event. For example, the extracted camera data source stored in the data source database 46630 may be sent to the odds calculation module 46622 to be used as the data source to calculate the wager odds. There may be a plurality of data sources sent to the odds calculation module 46622 to calculate the wager odds in some embodiments. For example, a camera may be used to calculate the odds for the upcoming result of a pitch, such as a strike or a ball, and data feed may be used to determine the odds of the wager for the upcoming result of a hit such as a single, double, triple, home run, etc. If the data source does not meet the requirements stored in the source threshold database 46632, then the source threshold module 46628 may extract, at step 46910, the next data source from the data source database 46630 and return to step 46904.

FIG. 470 illustrates the data source database 46630. The data source database 46630 may contain a list of available data sources from a live event 46602, including cameras, video feed, audio feed, sensors on the field, sensors on the players, sensors on the officials, referees, or umpires, a data feed such as SportsRadar or Trackman. In some embodiments, the data sources may include a plurality of sensors that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. The data source database 46630 may also contain a source number, the event for which the data source is collecting data, a source identification (ID), the type of data source, and various parameters that list the details of what the data source provides. In some embodiments, the parameters may be the players in the live event 46602, how many players are currently involved in an upcoming play, the score of the live event 46602, the time in the live event 46602, actions performed in the live event 46602, for example in baseball a type of pitch thrown, the location of the pitch, if the pitch was a ball or strike, a hit such as a single, double, etc., a stolen base, etc. In some embodiments, the data source database 46630 may include the wagering market associated with the parameter. For example, if the parameter is for hits in a baseball game, then the associated wager market may be the odds for the batter to hit a single, double, triple, home run, etc. Another example may if the parameter is for the pitches thrown and the resulting outcome such as a strike or ball, then the associated wager market may be for the odds on the results of a pitch.

FIG. 471 illustrates the source threshold database 46632. The source threshold database 46632 may contain a list of thresholds that the available data sources stored in the data source database 46630 are compared to during the process described in the source threshold module 46628. The source threshold database 46632 may contain the type of event, such as baseball, football, basketball, hockey, etc., and the requirements for the data source such as the number of players in the field of play, the names of players, the score of the event, the time in the event, and “N” representing an infinite number of potential requirements. In some embodiments, the requirements may include cameras, video feed, audio feed, sensors on the field, sensors on the players, sensors on the officials, referees, or umpires, a data feed such as SportsRadar or Trackman. In some embodiments, the requirements may include a plurality of sensors such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. In some embodiments, a plurality or all of the requirements may need to be reached or exceeded for the data source to be sent to the odds calculation module 46622. Only one requirement may need to be reached or exceeded in some embodiments for the data source to be sent to the odds calculation module 46622. In some embodiments, the requirements may be based on a specific wager market. For example, if the wagering market is for the outcome of a hit in a baseball game, such as single, double, triple, home run, etc., then the data source may only be required to have the data for the result of a hit. Another example may be if the wagering market is for the outcome of a pitch, such as a strike or a ball, then the data source may only be required to contain the outcome of a pitch.

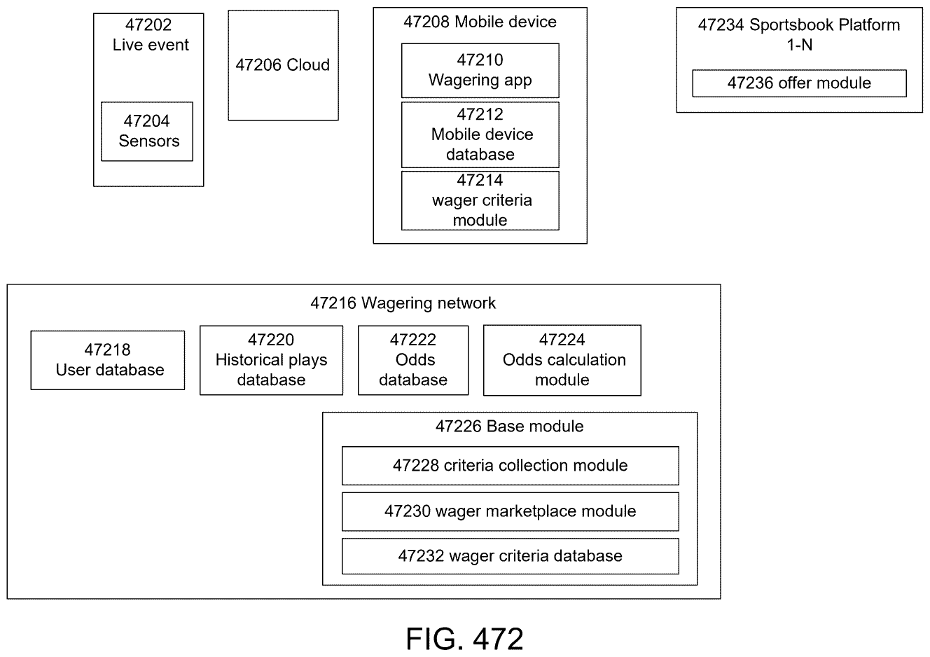

FIG. 472 illustrates a method for a user to propose a wager to the house, according to an embodiment.

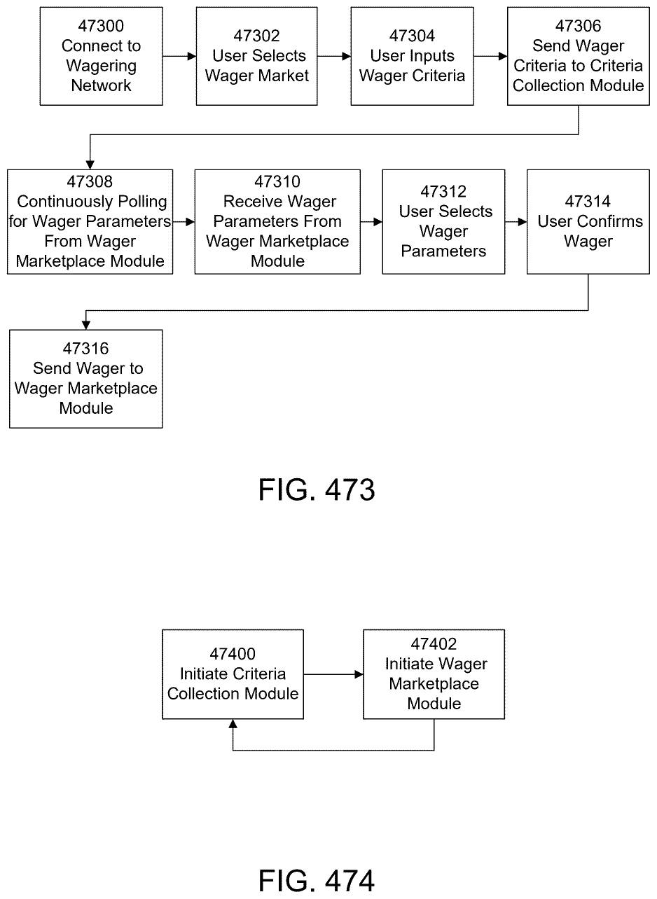

FIG. 473 illustrates a wager criteria module, according to an embodiment.

FIG. 474 illustrates a base module, according to an embodiment.

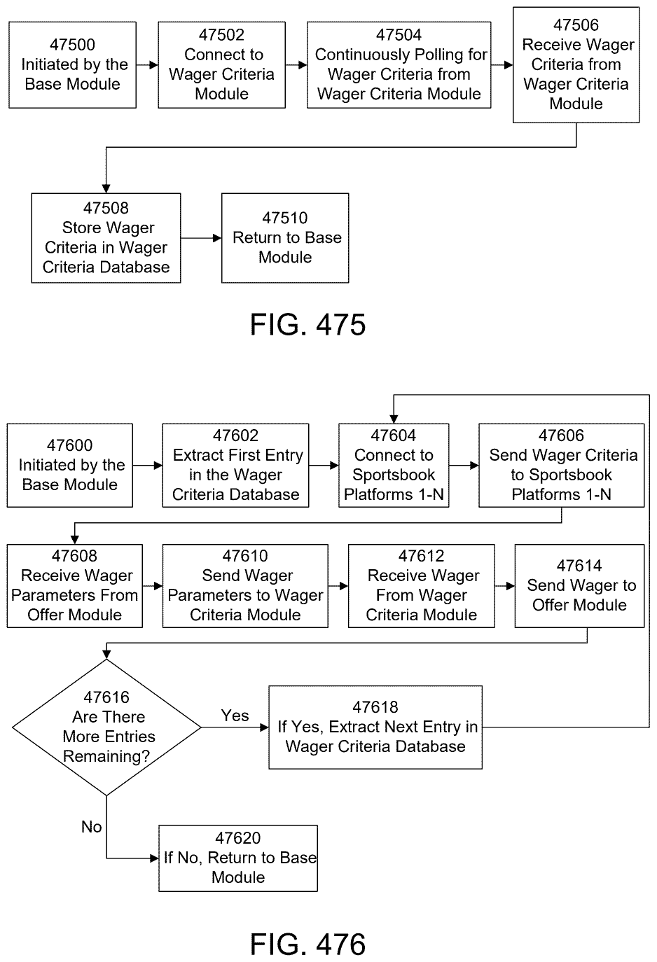

FIG. 475 illustrates a criteria collection module, according to an embodiment.

FIG. 476 illustrates a wager marketplace module, according to an embodiment.

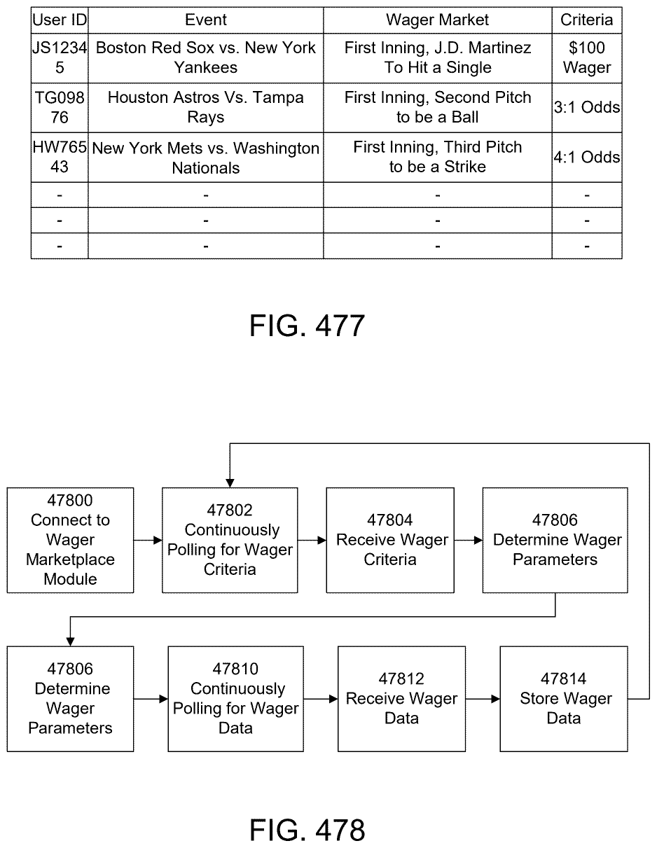

FIG. 477 illustrates a wager criteria database, according to an embodiment.

FIG. 478 illustrates an offer module, according to an embodiment.

FIG. 472 is a method for a user to propose a wager to the house. This system may include a live event 47202, for example, a sporting event such as a football, basketball, baseball, or hockey game, tennis match, golf tournament, eSports or digital game, etc. The live event 47202 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 47202, such as the score of an American football game or the run line in a baseball game, or a series of actions in the live event 47202. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 47202 or at another location.

Further, embodiments may include a plurality of sensors 47204 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 47204 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 47206 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 47206 may be communicatively coupled to a peer-to-peer wagering network 47214, which may perform real-time analysis on the type of play and the result of the play. The cloud 47206 may also be synchronized with game situational data such as the time of the game, the score, location on the field, weather conditions, and the like, which may affect the choice of play utilized. For example, in an exemplary embodiment, the cloud 47206 may not receive data gathered from the sensors 47204 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 47208 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 47208 could be an optional component and would be utilized in a situation where a paired wearable device employs the mobile device 47208 for additional memory or computing power or connection to the internet.

Further, Further, embodiments may include a wagering software application or a wagering app 47210, which is a program that enables the user to place bets on individual plays in the live event 47202, streams audio and video from the live event 47202, and features the available wagers from the live event 47202 on the mobile device 47208. The wagering app 47210 allows the user to interact with the wagering network 47216 to place bets and provide payment/receive funds based on wager outcomes.

Further, embodiments may include a mobile device database 47212 that may store some or all the user's data, the live event 47202, or the user's interaction with a wagering network 47216.

Further, embodiments may include a wager criteria module 47214, which may begin with the wager criteria module 47214 connecting to the wagering network 47216. Then the user selects a wagering market. For example, the user may select the Boston Red Sox vs. the New York Yankees and the wagering market of J. D. Martinez to hit a single. Then the user inputs wager criteria. For example, the user may input the desired wager amount, such as a wager of $100 on the selected wager market or the odds they desire to place a wager on the selected wager market. Then the wager criteria module 47214 sends the wager criteria to the criteria collection module 47228. For example, the wager criteria module 47214 sends the event being the Boston Red Sox vs. the New York Yankees and the wagering market of J. D. Martinez to hit a single, and that the user desires to place a $100 wager on the wagering market. The wager criteria module 47214 then continuously poll for the wager parameters from a wager marketplace module 47230. For example, the wager criteria module 47214 continuously polls for the various parameters inputted by the sportsbook platforms 1-N 134 and sent to the wager marketplace module 47230, such as for the sportsbook platforms 1-N 134 provide the wager odds, for example, 2:1, 3:1, 4:1, 3.5:1, etc. for the user's $100 wager on the wagering market of J. D. Martinez to hit a single in the event being the Boston Red Sox vs. the New York Yankees. Then the wager criteria module 47214 receives the wager parameters from the wager marketplace module 47230. For example, the wager criteria module 47214 receives the wager parameters, such as the various odds, such as 2:1, 3:1, 4:1, 3.5:1, etc., from the wager marketplace module 47230 via the sportsbook platforms 1-N 134 that the various sportsbook platforms 1-N 134 would take a $100 wager for J. D. Martinez to hit a single in the event of the Boston Red Sox vs. the New York Yankees. Then the user selects the wager parameters. For example, the user selects the desired parameters for the selected wager criteria, such as if the user desires to place $100 on J. D. Martinez to hit a single in the event of the Boston Red Sox vs. the New York Yankees, there would be various odds provided by the sportsbook platforms 1-N 134 the user would be able to select from, such as 2:1, 3:1, 4:1, 3.5:1, etc. For example, the user may select the odds 4:1 provided by one of the sportsbook platforms 1-N 134 for their $100 wager on J. D. Martinez to hit a single in the event of the Boston Red Sox vs. the New York Yankees. The user confirms the wager. For example, the user confirms the odds of 4:1 provided by one of the sportsbook platforms 1-N 134 for their $100 wager on J. D. Martinez to hit a single in the Boston Red Sox vs. the New York Yankees event. Then the wager criteria module 47214 sends the confirmed wager to the wager marketplace module 47230. For example, the wager criteria module 47214 sends the user's confirmation wager of 4:1 odds provided by one of the sportsbook platforms 1-N 47234 for their $100 wager on J. D. Martinez to hit a single in the event of Boston Red Sox vs. the New York Yankees.

Further, embodiments may include the wagering network 47216, which may perform real-time analysis on the type of play and the result of a play or action. The wagering network 47216 (or the cloud 47206) may also be synchronized with game situational data, such as the time of the game, the score, location on the field, weather conditions, and the like, which may affect the choice of play utilized. For example, in an exemplary embodiment, the wagering network 47216 may not receive data gathered from the sensors 47204 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 47216 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 47218, which may contain data relevant to all users of the wagering network 47216 and may include, but is not limited to, a user ID, a device identifier, a paired device identifier, wagering history, or wallet information for the user. The user database 47218 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, user database 47218 may contain betting lines and search queries. The user database 47218 may be searched based on a search criterion received from the user. Each betting line may include, but is not limited to, a plurality of betting attributes such as at least one of the live event 47202, a team, a player, an amount of wager, etc. The user database 47218 may include, but is not limited to, information related to all the users involved in the live event 47202. In one exemplary embodiment, the user database 47218 may include information for generating a user authenticity report and a wagering verification report. Further, the user database 47218 may be used to store user statistics like, but not limited to, the retention period for a particular user, frequency of wagers placed by a particular user, the average amount of wager placed by each user, etc.

Further, embodiments may include a historical plays database 47220 that may contain play data for the type of sport being played in the live event 47202. For example, in American Football, for optimal odds calculation, the historical play data may include metadata about the historical plays, such as time, location, weather, previous plays, opponent, physiological data, etc.

Further, embodiments may utilize an odds database 47222—that contains the odds calculated by the odds calculation module 47224—to display the odds on the user's mobile device 47208 and take bets from the user through the mobile device wagering app 47210.

Further, embodiments may include the odds calculation module 47224, which utilizes historical play data to calculate odds for in-play wagers.

Further, embodiments may include a base module 47226, which may initiate a criteria collection module 47228. For example, the criteria collection module 47228 connects to the wager criteria module 47214. The criteria collection module 47228 continuously polls for the user's wager criteria from the wager criteria module 47214. Then the criteria collection module 47228 receives the user's wager criteria from the wager criteria module 47214 and stores the user's wager criteria in a wager criteria database 47232. Then the criteria collection module 47228 returns to the base module 47226. Then the base module 47226 initiates the wager marketplace module 47230. For example, the wager marketplace module 47230 may extract the first entry stored in the wager criteria database 47232. The wager marketplace module 47230 connects to a sportsbook platforms 1-N 47234. Then the wager marketplace module 47230 sends the extracted wager criteria to the sportsbook platforms 1-N 47234. The wager marketplace module 47230 receives the wager parameters from an offer module 47236. Then the wager marketplace module 47230 sends the wager parameters to the wager criteria module 47214. Then the wager marketplace module 47230 receives the confirmed wager from the wager criteria module 47214. Then the wager marketplace module 47230 sends the confirmed wager to the offer module 47236. Then it is determined if more entries are remaining in the wager criteria database 47232. If it is determined that more entries are remaining in the wager criteria database, then the wager marketplace module 47230 extracts the next entry in the wager criteria database 47232, and the process returns to connecting to the sportsbook platforms 1-N 47234. If it is determined that there are no more entries remaining in the wager criteria database 47232, then the wager marketplace module 47230 returns to the base module 47226.

Further, embodiments may include the criteria collection module 47228, which may connect to the wager criteria module 47214. The criteria collection module 47228 continuously polls for the user's wager criteria from the wager criteria module 47214. For example, the criteria collection module 47228 continuously polls for the user's wager criteria, such as they desire to place a $100 wager on J. D. Martinez to hit a single in the event of the Boston Red Sox vs. the New York Yankees. Then the criteria collection module 47228 receives the user's wager criteria from the wager criteria module 47214. For example, the criteria collection module 47228 receives that the user desires to place a $100 wager on J. D. Martinez to hit a single in the Boston Red Sox vs. the New York Yankees event. Then the criteria collection module 47228 stores the user's wager criteria in the wager criteria database 47232. For example, the criteria collection module 47228 stores the user ID, such as JS12345, the event, such as the Boston Red Sox vs. the New York Yankees, the wagering market, such as J. D. Martinez to hit a single in the wager criteria database 47232. Then the criteria collection module 47228 returns to the base module 47226.

Further, embodiments may include the wager marketplace module 47230, which may extract the first entry stored in the wager criteria database 47232. For example, the wager marketplace module 47230 extracts the first entry such as the user ID, such as JS12345, the event, such as the Boston Red Sox vs. the New York Yankees, the wagering market, such as J. D. Martinez to hit a single, and the wager criteria, such as $100 in the wager criteria database 47232. The wager marketplace module 47230 connects to the sportsbook platforms 1-N 47234. For example, the wager marketplace module 47230 connects to the various sportsbook platforms 1-N 47234, which may be third party networks for sportsbooks, for example, casino sportsbooks, such as MGM, Caesars, Wynn, etc., independent sportsbooks, such as DraftKings, FanDuel, etc. or state-operated sportsbooks, such as Rhode Island Sportsbook, etc. The sportsbook platforms 1-N 47234 may connect to the wagering network 47216 to view various user's wager criteria and then offer wager parameters to select their sportsbook to place a wager. For example, if a user desired to place $100 wager on J. D. Martinez to hit a single in the first inning of the Boston Red Sox vs. the New York Yankees event, the sportsbook platforms 1-N may offer wager parameters, such as the odds they would take the $100 wager on, for example, 3:1, 2:1, 4:1, etc. to try and entice the user to place a wager with their sportsbook as opposed to another sportsbook. Then the wager marketplace module 47230 sends the extracted wager criteria to the sportsbook platforms 1-N 47234. For example, the wager marketplace module 47230 may send a user who desires to place a $100 wager on J. D. Martinez to hit a single in the Boston Red Sox vs. the New York Yankees event. The wager marketplace module 47230 receives the wager parameters from the offer module 47236. For example, the wager marketplace module 47230 may receive the wager parameters from the sportsbook platforms 1-N 47234, such as the odds, 2:1, 3:1, 4:1, 3.5:1, etc. that the sportsbooks would be willing to take the user's $100 wager on J. D. Martinez to hit a single in the event of the Boston Red Sox vs. the New York Yankees. Then the wager marketplace module 47230 sends the wager parameters to the wager criteria module 47214. For example, the wager marketplace module 47230 sends the wager parameters, such as the various odds, such as 2:1, 3:1, 4:1, 3.5:1, etc., from the sportsbook platforms 1-N 47234 that the various sportsbook platforms 1-N 47234 would take a $100 wager for J. D. Martinez to hit a single in the event of the Boston Red Sox vs. the New York Yankees. Then the wager marketplace module 47230 receives the confirmed wager from the wager criteria module 47214. For example, the wager marketplace module 47230 receives the user's confirmed wager of 4:1 odds provided by one of the sportsbook platforms 1-N 47234 for their $100 wager on J. D. Martinez to hit a single in the Boston Red Sox vs. the New York Yankees event. In some embodiments, the selected sportsbook platform 1-N 47234 may be stored in the wager criteria database 47232. Then the wager marketplace module 47230 sends the confirmed wager to the offer module 47236. For example, the wager marketplace module 47230 sends the confirmed wager to the sportsbook platform 1-N that offered 4:1 odds on the user's wager of $100 on J. D. Martinez to hit a single in the event of the Boston Red Sox vs. the New York Yankees. Then it is determined if more entries are remaining in the wager criteria database 47232. For example, the wager marketplace module 47230 may select the next entry stored in the wager criteria database 47232 to offer the wager criteria of another user to the various sportsbook platforms 1-N 47234. If it is determined that more entries are remaining in the wager criteria database, then the wager marketplace module 47230 extracts the next entry in the wager criteria database 47232, and the process returns to connecting to the sportsbook platforms 1-N 47234. If it is determined that there are no more entries remaining in the wager criteria database 47232, then the wager marketplace module 47230 returns to the base module 47226.

Further, embodiments may include the wager criteria database 47232. The database may contain the user ID, such as JS12345, the event, such as the Boston Red Sox vs. the New York Yankees, the wagering market, such as J. D. Martinez, to hit a single the wager criteria, such as $100. In some embodiments, the wager criteria may be a dollar amount a user desires to place on a specific wager market or odds the user wishes to receive on a specific wager market. In some embodiments, the wager parameters and the associated sportsbook may be stored in the database, for example, if MGM casino offers the wager parameters of 4:1 odds for the $100 wager on J. D. Martinez to hit a single in the event of the Boston Red Sox vs. the New York Yankees. In some embodiments, the wager parameters may be a dollar amount the sportsbook is willing to allow the user to wager if the user's wager criteria are specific odds on a specific wager market, or the wager parameters may be odds the sportsbooks would allow for the dollar amount entered by the user on a specific wager market.

Further, embodiments may include various sportsbook platforms 1-N 47234, which may be third party networks for sportsbooks, for example, casino sportsbooks, such as MGM, Caesars, Wynn, etc., independent sportsbooks, such as DraftKings, FanDuel, etc. or state-operated sportsbooks, such as Rhode Island Sportsbook, etc. The sportsbook platforms 1-N 47234 may connect to the wagering network 47216 to view various user's wager criteria and then offer wager parameters for the user to select their sportsbook to place a wager. For example, if a user desired to place $100 wager on J. D. Martinez to hit a single in the first inning of the Boston Red Sox vs. the New York Yankees event, the sportsbook platforms 1-N may offer wager parameters, such as the odds they would take the $100 wager on, for example, 3:1, 2:1, 4:1, etc. to try and entice the user to place a wager with their sportsbook as opposed to another sportsbook.

Further, embodiments may include the offer module 47236, which may begin with the offer module 47236 connecting to the wager marketplace module 47230. Then the offer module 47236 continuously polls for the wager criteria from the wager marketplace module 47230. For example, the offer module 47236 continuously polls to receive the wager criteria from the wager marketplace module 47230, such as the user's inputted criteria, which may be a dollar amount or wager odds on a specific market. The offer module 47236 receives the wager criteria from the wager marketplace module 47230. For example, the offer module 47236 receives the wager criteria from the wager marketplace module 47230, such as the user's inputted criteria, which may be a dollar amount or wager odds on a specific market. Then the offer module 47236 determines the wager parameters. For example, if the wager criteria is a dollar amount, the offer module 47236 may determine how much money is already on the wagering market, such as J. D. Martinez to hit a single. The offer module 47236 may offer higher odds, such as 3:1 or 4:1, to get the user to wager on the wagering market, or if there is already too much money on the wagering market, the offer module 47236 may offer lower odds, such as 2:1 or 1.5:1. In some embodiments, a program's determination may be performed on the sportsbook to keep even money or even action on both sides of the wager. In some embodiments, the determination may be performed by an administrator of the sportsbook platform 1-N 47234. Then the offer module 47236 sends the wager parameters to the wager marketplace module 47230. For example, the offer module 47236 may send the wager parameters to the wager marketplace module 47230, such as the odds, 2:1, 3:1, 4:1, 3.5:1, etc. that the sportsbooks would be willing to take the user's $100 wager on J. D. Martinez to hit a single in the event of the Boston Red Sox vs. the New York Yankees. Then the offer module 47236 continuously polls for the confirmed wager data. For example, the offer module 47236 continuously polls for the confirmed wager data, such as the user selected the sportsbook to place the $100 wager for J. D. Martinez to hit a single in the event of the Boston Red Sox vs. the New York Yankees. In some embodiments, the offer module 47236 may receive a notification that the user did not select the sportsbook to place their wager, and the process would return to the offer module 47236, continuously polls for the wager criteria from the wager marketplace module 47230. Then the offer module 47236 receives the confirmed wager data. For example, the offer module 47236 receives the confirmed wager data of the $100 wager for J. D. Martinez to hit a single in the Boston Red Sox vs. the New York Yankees event. The offer module 47236 stores the confirmed wager data, and the process returns to the offer module 47236, continuously polls for the wager criteria from the wager marketplace module 47230.

FIG. 473 illustrates the wager criteria module 47214. The process begins with the wager criteria module 47214 connecting, at step 47300, to the wagering network 47216. Then the user selects, at step 47302, a wagering market. For example, the user may select the Boston Red Sox vs. the New York Yankees event and the wager market of J. D. Martinez to hit a single. Then the user inputs, at step 47304, wager criteria. For example, the user may input the desired wager amount, such as a wager of $100 on the selected wager market or the odds they desire to place a wager on the selected wager market. Then the wager criteria module 47214 sends, at step 47306, the wager criteria to the criteria collection module 47228. For example, the wager criteria module 47214 sends the event being the Boston Red Sox vs. the New York Yankees and the wagering market of J. D. Martinez to hit a single, and that the user desires to place a $100 wager on the wagering market. The wager criteria module 47214 continuously polls, at step 47308, for the wager parameters from the wager marketplace module 47230. For example, the wager criteria module 47214 continuously polls for the various parameters inputted by the sportsbook platforms 1-N 47234 and sent to the wager marketplace module 47230, such as for the sportsbook platforms 1-N 47234 provide the wager odds, for example, 2:1, 3:1, 4:1, 3.5:1, etc. for the user's $100 wager on the wager market of J. D. Martinez to hit a single in the event being the Boston Red Sox vs. the New York Yankees. Then the wager criteria module 47214 receives, at step 47310, the wager parameters from the wager marketplace module 47230. For example, the wager criteria module 47214 receives the wager parameters, such as the various odds, such as 2:1, 3:1, 4:1, 3.5:1, etc., from the wager marketplace module 47230 via the sportsbook platforms 1-N 47234 that the various sportsbook platforms 1-N 47234 would take a $100 wager for J. D. Martinez to hit a single in the event of the Boston Red Sox vs. the New York Yankees. Then the user selects, at step 47312, the wager parameters. For example, the user selects the desired parameters for the selected wager criteria, such as if the user desires to place $100 on J. D. Martinez to hit a single in the event of the Boston Red Sox vs. the New York Yankees, there would be various odds provided by the sportsbook platforms 1-N 47234 the user would be able to select from, such as 2:1, 3:1, 4:1, 3.5:1, etc. For example, the user may select the odds 4:1 provided by one of the sportsbook platforms 1-N 47234 for their $100 wager on J. D. Martinez to hit a single in the event of the Boston Red Sox vs. the New York Yankees. The user confirms, at step 47314, the wager. For example, the user confirms the odds of 4:1 provided by one of the sportsbook platforms 1-N 47234 for their $100 wager on J. D. Martinez to hit a single in the Boston Red Sox vs. the New York Yankees event. Then the wager criteria module 47214 sends, at step 47316, the confirmed wager to the wager marketplace module 47230. For example, the wager criteria module 47214 sends the user confirms a wager of 4:1 odds provided by one of the sportsbook platforms 1-N 47234 for their $100 wager on J. D. Martinez to hit a single in the Boston Red Sox vs. the New York Yankees event.

FIG. 474 illustrates the base module 47226. The process begins with the base module 47226 initiating, at step 47400, the criteria collection module 47228. For example, the criteria collection module 47228 connects to the wager criteria module 47214. The criteria collection module 47228 continuously polls for the user's wager criteria from the wager criteria module 47214. For example, the criteria collection module 47228 continuously polls for the user's wager criteria, such as they desire to place a $100 wager on J. D. Martinez to hit a single in the event of the Boston Red Sox vs. the New York Yankees. Then the criteria collection module 47228 receives the user's wager criteria from the wager criteria module 47214. For example, the criteria collection module 47228 receives that the user desires to place a $100 wager on J. D. Martinez to hit a single in the Boston Red Sox vs. the New York Yankees event. Then the criteria collection module 47228 stores the user's wager criteria in the wager criteria database 47232. For example, the criteria collection module 47228 stores the user ID, such as JS12345, the event, such as the Boston Red Sox vs. the New York Yankees, the wagering market, such as J. D. Martinez to hit a single in the wager criteria database 47232. Then the criteria collection module 47228 returns to the base module 47226. Then the base module 47226 initiates, at step 47402, the wager marketplace module 47230. For example, the wager marketplace module 47230 may extract the first entry stored in the wager criteria database 47232. For example, the wager marketplace module 47230 extracts the first entry such as the user ID, such as JS12345, the event, such as the Boston Red Sox vs. the New York Yankees, the wagering market, such as J. D. Martinez to hit a single, and the wager criteria, such as $100 in the wager criteria database 47232. The wager marketplace module 47230 connects to the sportsbook platforms 1-N 47234. For example, the wager marketplace module 47230 connects to the various sportsbook platforms 1-N 47234, which may be third party networks for sportsbooks, for example, casino sportsbooks, such as MGM, Caesars, Wynn, etc., independent sportsbooks, such as DraftKings, FanDuel, etc. or state-operated sportsbooks, such as Rhode Island Sportsbook, etc. The sportsbook platforms 1-N 47234 may connect to the wagering network 47216 to view various user's wager criteria and then offer wager parameters for the user to select their sportsbook to place a wager. For example, if a user desired to place $100 wager on J. D. Martinez to hit a single in the first inning of the Boston Red Sox vs. the New York Yankees event, the sportsbook platforms 1-N may offer wager parameters, such as the odds they would take the $100 wager on, for example, 3:1, 2:1, 4:1, etc. to try and entice the user to place a wager with their sportsbook as opposed to another sportsbook. Then the wager marketplace module 47230 sends the extracted wager criteria to the sportsbook platforms 1-N 47234. For example, the wager marketplace module 47230 may send a user who desires to place a $100 wager on J. D. Martinez to hit a single in the Boston Red Sox vs. the New York Yankees event. The wager marketplace module 47230 receives the wager parameters from the offer module 47236. For example, the wager marketplace module 47230 may receive the wager parameters from the sportsbook platforms 1-N 47234, such as the odds, 2:1, 3:1, 4:1, 3.5:1, etc. that the sportsbooks would be willing to take the user's $100 wager on J. D. Martinez to hit a single in the event of the Boston Red Sox vs. the New York Yankees. Then the wager marketplace module 47230 sends the wager parameters to the wager criteria module 47214. For example, the wager marketplace module 47230 sends the wager parameters, such as the various odds, such as 2:1, 3:1, 4:1, 3.5:1, etc., from the sportsbook platforms 1-N 47234 that the various sportsbook platforms 1-N 47234 would take a $100 wager for J. D. Martinez to hit a single in the event of the Boston Red Sox vs. the New York Yankees. Then the wager marketplace module 47230 receives the confirmed wager from the wager criteria module 47214. For example, the wager marketplace module 47230 receives the user's confirmed wager of 4:1 odds provided by one of the sportsbook platforms 1-N 47234 for their $100 wager on J. D. Martinez to hit a single in the Boston Red Sox vs. the New York Yankees event. In some embodiments, the selected sportsbook platform 1-N 47234 may be stored in the wager criteria database 47232. Then the wager marketplace module 47230 sends the confirmed wager to the offer module 47236. For example, the wager marketplace module 47230 sends the confirmed wager to the sportsbook platform 1-N 47234 that offered 4:1 odds on the user's wager of $100 on J. D. Martinez to hit a single in the event of the Boston Red Sox vs. the New York Yankees. Then it is determined if more entries are remaining in the wager criteria database 47232. For example, the wager marketplace module 47230 may select the next entry stored in the wager criteria database 47232 to offer the wager criteria of another user to the various sportsbook platforms 1-N 47234. If it is determined that more entries are remaining in the wager criteria database, then the wager marketplace module 47230 extracts the next entry in the wager criteria database 47232, and the process returns to connecting to the sportsbook platforms 1-N 47234. If it is determined that there are no more entries remaining in the wager criteria database 47232, then the wager marketplace module 47230 returns to the base module 47226.

FIG. 475 illustrates the criteria collection module 47228. The process begins with the criteria collection module 47228 being initiated, at step 47500, by the base module 47226. Then the criteria collection module 47228 connects, at step 47502, to the wager criteria module 47214. The criteria collection module 47228 continuously polls, at step 47504, for the user's wager criteria from the wager criteria module 47214. For example, the criteria collection module 47228 continuously polls for the user's wager criteria, such as they desire to place a $100 wager on J. D. Martinez to hit a single in the event of the Boston Red Sox vs. the New York Yankees. Then the criteria collection module 47228 receives, at step 47506, the user's wager criteria from the wager criteria module 47214. For example, the criteria collection module 47228 receives that the user desires to place a $100 wager on J. D. Martinez to hit a single in the Boston Red Sox vs. the New York Yankees event. Then the criteria collection module 47228 stores, at step 47508, the user's wager criteria in the wager criteria database 47232. For example, the criteria collection module 47228 stores the user ID, such as JS12345, the event, such as the Boston Red Sox vs. the New York Yankees, the wagering market, such as J. D. Martinez to hit a single and the wager criteria such as $100 in the wager criteria database 47232. Then the criteria collection module 47228 returns, at step 47510, to the base module 47226.

FIG. 476 illustrates wager marketplace module 47230. The process begins with the wager marketplace module 47230 being initiated, at step 47600, by the base module 47226. Then the wager marketplace module 47230 extracts, at step 47602, the first entry stored in the wager criteria database 47232. For example, the wager marketplace module 47230 extracts the first entry such as the user ID, such as JS12345, the event, such as the Boston Red Sox vs. the New York Yankees, the wagering market, such as J. D. Martinez to hit a single, and the wager criteria, such as $100 in the wager criteria database 47232. The wager marketplace module 47230 connects, at step 47604, to the sportsbook platforms 1-N 47234. For example, the wager marketplace module 47230 connects to the various sportsbook platforms 1-N 47234, which may be third party networks for sportsbooks, for example, casino sportsbooks, such as MGM, Caesars, Wynn, etc., independent sportsbooks, such as Draftkings, FanDuel, etc. or state-operated sportsbooks, such as Rhode Island Sportsbook, etc. The sportsbook platforms 1-N 47234 may connect to the wagering network 47216 to view various user's wager criteria and then offer wager parameters for the user to select their sportsbook to place a wager. For example, if a user desired to place $100 wager on J. D. Martinez to hit a single in the first inning of the Boston Red Sox vs. the New York Yankees event, the sportsbook platforms 1-N may offer wager parameters, such as the odds they would take the $100 wager on, for example, 3:1, 2:1, 4:1, etc. to try and entice the user to place a wager with their sportsbook as opposed to another sportsbook. Then the wager marketplace module 47230 sends, at step 47506, the extracted wager criteria to the sportsbook platforms 1-N 47234. For example, the wager marketplace module 47230 may send a user who desires to place a $100 wager on J. D. Martinez to hit a single in the Boston Red Sox vs. the New York Yankees event. The wager marketplace module 47230 receives, at step 47608, the wager parameters from the offer module 47236. For example, the wager marketplace 47230 may receive the wager parameters from the sportsbook platforms 1-N 47234, such as the odds, 2:1, 3:1, 4:1, 3.5:1, etc. that the sportsbooks would be willing to take the user's $100 wager on J. D. Martinez to hit a single in the event of the Boston Red Sox vs. the New York Yankees. Then the wager marketplace module 47230 sends, at step 47610, the wager parameters to the wager criteria module 47214. For example, the wager marketplace module 47230 sends the wager parameters, such as the various odds, such as 2:1, 3:1, 4:1, 3.5:1, etc., from the sportsbook platforms 1-N 47234 that the various sportsbook platforms 1-N 47234 would take a $100 wager for J. D. Martinez to hit a single in the event of the Boston Red Sox vs. the New York Yankees. Then the wager marketplace module 47230 receives, at step 47612, the confirmed wager from the wager criteria module 47214. For example, the wager marketplace module 47230 receives the user's confirmed wager of 4:1 odds provided by one of the sportsbook platforms 1-N 47234 for their $100 wager on J. D. Martinez to hit a single in the Boston Red Sox vs. the New York Yankees event. In some embodiments, the selected sportsbook platform 1-N 47234 may be stored in the wager criteria database 47232. Then the wager marketplace module 47230 sends, at step 47614, the confirmed wager to the offer module 47236. For example, the wager marketplace module 47230 sends the confirmed wager to the sportsbook platform 1-N that offered 4:1 odds on the user's wager of $100 on J. D. Martinez to hit a single in the event of the Boston Red Sox vs. the New York Yankees. Then it is determined, at step 47616, if more entries remain in the wager criteria database 47232. For example, the wager marketplace module 47230 may select the next entry stored in the wager criteria database 47232 to offer the wager criteria of another user to the various sportsbook platforms 1-N 47234. If it is determined that more entries remain in the wager criteria database, then the wager marketplace module 47230 extracts, at step 47618, the next entry in the wager criteria database 47232, and the process returns to connecting to the sportsbook platforms 1-N 47234. If it is determined that there are no more entries remaining in the wager criteria database 47232, then the wager marketplace module 47230 returns, at step 47620, to the base module 47226.

FIG. 477 illustrates the wager criteria database 47232. The database may contain the user ID, such as JS12345, the event, such as the Boston Red Sox vs. the New York Yankees, the wagering market, such as J. D. Martinez, to hit a single the wager criteria, such as $100. In some embodiments, the wager criteria may be a dollar amount a user desires to place on a specific wager market or odds the user wishes to receive on a specific wager market. In some embodiments, the wager parameters and the associated sportsbook may be stored in the database, for example, if MGM casino offers the wager parameters of 4:1 odds for the $100 wager on J. D. Martinez to hit a single in the event of the Boston Red Sox vs. the New York Yankees. In some embodiments, the wager parameters may be a dollar amount the sportsbook is willing to allow the user to wager if the user's wager criteria are specific odds on a specific wager market, or the wager parameters may be odds the sportsbooks would allow for the dollar amount entered by the user on a specific wager market.

FIG. 478 illustrates the offer module 47236. The process begins with the offer module 47236 connecting, at step 47800, to the wager marketplace module 47230. Then, the offer module 47236 continuously polls at step 47802 for the wager criteria from the wager marketplace module 47230. For example, the offer module 47236 continuously polls to receive the wager criteria from the wager marketplace module 47230, such as the user's inputted criteria, which may be a dollar amount or wager odds on a specific market. The offer module 47236 receives, at step 47804, the wager criteria from the wager marketplace module 47230. For example, the offer module 47236 receives the wager criteria from the wager marketplace module 47230, such as the user's inputted criteria, which may be a dollar amount or wager odds on a specific market. Then the offer module 47236 determines, at step 47806, the wager parameters. For example, if the wager criteria is a dollar amount, the offer module 47236 may determine how much money is already on the wagering market, such as J. D. Martinez to hit a single. The offer module 47236 may offer higher odds, such as 3:1 or 4:1, to get the user to wager on the wagering market, or if there is already too much money on the wagering market, the offer module 47236 may offer lower odds, such as 2:1 or 1.5:1. In some embodiments, a program's determination may be performed on the sportsbook to keep even money or even action on both sides of the wager. In some embodiments, the determination may be performed by an administrator of the sportsbook platform 1-N 47234. Then the offer module 47236 sends, at step 47808, the wager parameters to the wager marketplace module 47230. For example, the offer module 47236 may send the wager parameters to the wager marketplace module 47230, such as the odds, 2:1, 3:1, 4:1, 3.5:1, etc. that the sportsbooks would be willing to take the user's $100 wager on J. D. Martinez to hit a single in the event of the Boston Red Sox vs. the New York Yankees. Then the offer module 47236 continuously polls, at step 47810, for the confirmed wager data. For example, the offer module 47236 continuously polls for the confirmed wager data, such as the user selected the sportsbook to place the $100 wager for J. D. Martinez to hit a single in the event of the Boston Red Sox vs. the New York Yankees. In some embodiments, the offer module 47236 may receive a notification that the user did not select the sportsbook to place their wager, and the process would return to the offer module 47236, and continuously poll for the wager criteria from the wager marketplace module 47230. Then the offer module 47236 receives, at step 47812, the confirmed wager data. For example, the offer module 47236 receives the confirmed wager data of the $100 wager for J. D. Martinez to hit a single in the Boston Red Sox vs. the New York Yankees event. The offer module 47236 stores, at step 47814, the confirmed wager data, and the process returns to the offer module 47236 continuously polling for the wager criteria from the wager marketplace module 47230.

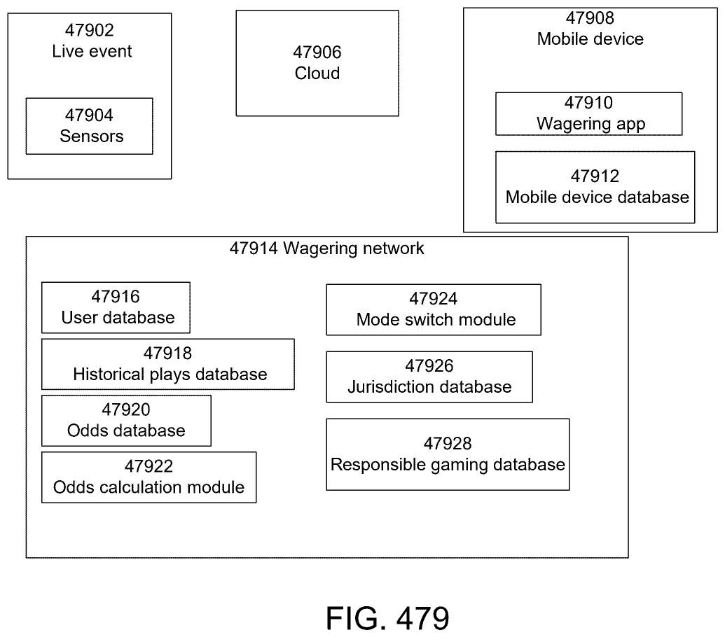

FIG. 479 illustrates a system for disabling cash value wagering, according to an embodiment.

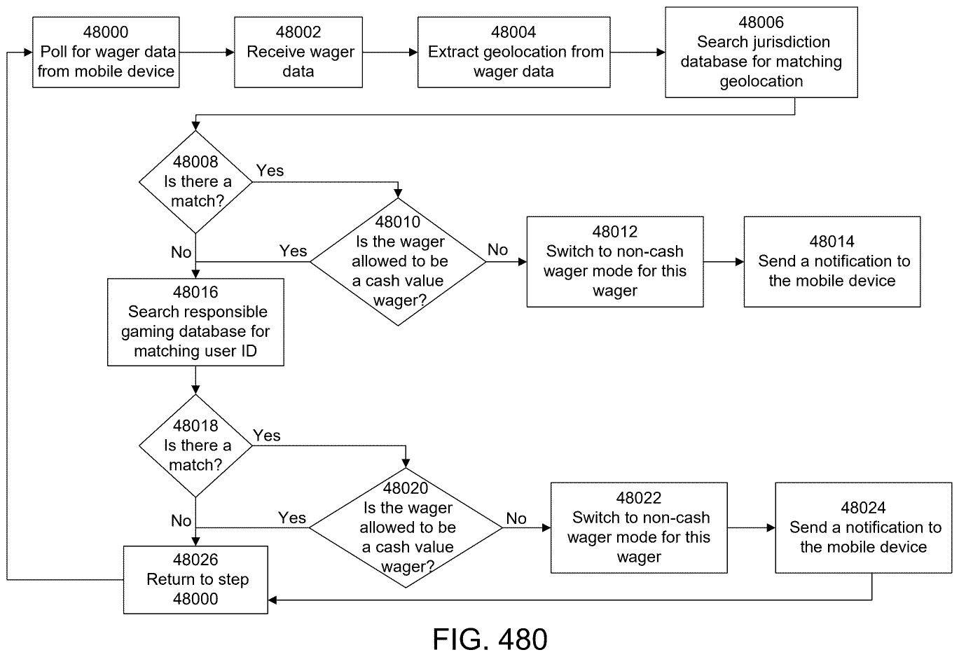

FIG. 480 illustrates a mode switch module, according to an embodiment.

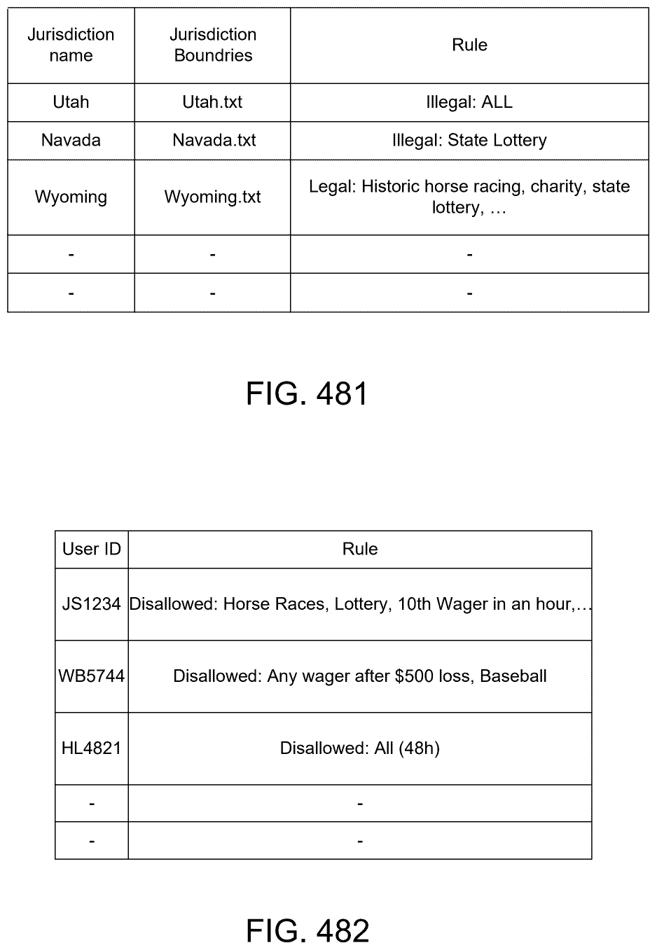

FIG. 481 illustrates a jurisdiction database, according to an embodiment.

FIG. 482 illustrates a responsible gaming database, according to an embodiment.

FIG. 479 is a system for a disabling cash value wagering. This system may include a live event 47902, for example, a sporting event such as a football, basketball, baseball, or hockey game, tennis match, golf tournament, eSports or digital game, etc. The live event 47902 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 47902, such as the score of an American football game or the run line in a baseball game, or a series of actions in the live event 47902. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 47902 or at another location.

Further, embodiments may include a plurality of sensors 47904 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 47904 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 47906 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 47906 may be communicatively coupled to a peer-to-peer wagering network 47914, which may perform real-time analysis on the type of play and the result of the play. The cloud 47906 may also be synchronized with game situational data such as the time of the game, the score, location on the field, weather conditions, and the like, which may affect the choice of play utilized. For example, in an exemplary embodiment, the cloud 47906 may not receive data gathered from the sensors 47904 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 47908 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or

Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 47908 could be an optional component and would be utilized in a situation where a paired wearable device employs the mobile device 47908 for additional memory or computing power or connection to the internet.

Further, embodiments may include a wagering software application or a wagering app 47910, which is a program that enables the user to place bets on individual plays in the live event 47902, streams audio and video from the live event 47902, and features the available wagers from the live event 47902 on the mobile device 47908. The wagering app 47910 allows the user to interact with the wagering network 47914 to place bets and provide payment/receive funds based on wager outcomes.

Further, embodiments may include a mobile device database 47912 that may store some or all the user's data, the live event 47902, or the user's interaction with the wagering network 47914.

Further, embodiments may include the wagering network 47914, which may perform real-time analysis on the type of play and the result of a play or action. The wagering network 47914 (or the cloud 47906) may also be synchronized with game situational data, such as the time of the game, the score, location on the field, weather conditions, and the like, which may affect the choice of play utilized. For example, in an exemplary embodiment, the wagering network 47914 may not receive data gathered from the sensors 47904 and may, instead, receive data from an alternative data feed, such as SportsRadar®. This data may be provided substantially immediately following the completion of any play, and may be compared with a variety of team data and league data based on a variety of elements, including the current down, possession, score, time, team, and so forth, as described in various exemplary embodiments herein. The wagering network 47914 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 47916, which may contain data relevant to all users of the wagering network 47914 and may include, but is not limited to, a user ID, a device identifier, a paired device identifier, wagering history, or wallet information for the user. The user database 47916 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 47916 may contain betting lines and search queries. The user database 47916 may be searched based on a search criterion received from the user. Each betting line may include, but is not limited to, a plurality of betting attributes such as at least one of the live event 47902, a team, a player, an amount of wager, etc. The user database 47916 may include, but is not limited to, information related to all the users involved in the live event 47902. In one exemplary embodiment, the user database 47916 may include information for generating a user authenticity report and a wagering verification report. Further, the user database 47916 may be used to store user statistics like, but not limited to, the retention period for a particular user, frequency of wagers placed by a particular user, the average amount of wager placed by each user, etc.

Further, embodiments may include a historical plays database 47918 that may contain play data for the type of sport being played in the live event 47902. For example, in American Football, for optimal odds calculation, the historical play data may include metadata about the historical plays, such as time, location, weather, previous plays, opponent, physiological data, etc.

Further, embodiments may utilize an odds database 47920—that contains the odds calculated by an odds calculation module 47922—to display the odds on the user's mobile device 47908 and take bets from the user through the mobile device wagering app 47910.

Further, embodiments may include the odds calculation module 47922, which utilizes historical play data to calculate odds for in-play wagers.

Further, embodiments may include a mode switch module 47924, which may switch the system between cash value wagering and non-cash value wagering. When this switch occurs may be based on if cash value wagering is legal in the jurisdiction where the user is wagering. The switch may also occur if a user-specific rule is triggered, for example, placing more than five cash value wagers in an hour, or some other threshold number of wagers. These rules may be tied to individual user behavior and may be targeted to reducing problem gambling or addictive gambling behavior.

Further, embodiments may include a jurisdiction database 47926, which may contain the boundaries that define a legally relevant jurisdiction and the associated rules regarding when/if cash value wagering is allowed in that jurisdiction.

Further, embodiments may include a responsible gaming database 47928, which may contain the user IDs with restrictions on cash value wagering and associated rules regarding when cash value wagering should be disabled. These rules may be set by an administrator of the system, a module detecting problem gambling behavior, or the user.

FIG. 480 illustrates the mode switch module 47924. The process may begin with the mode switch module 47924 polling, at step 48000, for wager data from the mobile device 47908. Wager data may include the type of wager made, the geolocation of the mobile device 47908, or the user ID. The wager type may include the method of wagering such as parimutuel, the game being wagered on such as baseball, the time the bet is being made, any other qualification that may be relevant to gambling laws, or any combination of these. This data may be sent before the user places the wager, for example, when the user first enters the wagering app 47910 or when the user starts placing a wager. The mode switch module 47924 may receive, at step 48002, the wager data from the mobile device 47908. The mode switch module 47924 may extract from the wager data, at step 48004, the geolocation data-which may be in the form of coordinates- and the user ID. The mode switch module 47924 may search, at step 48006, the jurisdiction database 47926 for a matching geolocation. A match may refer to a jurisdiction that contains the coordinates within its boundaries. A match may not need to be an exact match; for example, the geolocation may be within 100 ft of the jurisdiction boundary and still match. The mode switch module 47924 may determine, at step 48008, if there is a match for the coordinates in the jurisdiction database 47926. If there is no match, the mode switch module 47924 may skip to step 48016. There may be more than one match if one jurisdiction resides within another or overlaps. If there is a match in the jurisdiction database 47926, the mode switch module 47924 may determine, at step 48010, if the wager can be a cash value wager by checking the jurisdiction's rule in the jurisdiction database 47926. If there are multiple matching jurisdictions, the mode switch module 47924 may make this determination for each jurisdiction. If any of the jurisdictions prohibit the wager from being a cash value wager, then the wager may not be allowed to be a cash value wager. The rule may indicate which types of wagers are not allowed to be cash value wagers based on the laws of the matching jurisdiction. If the wager can be a cash value wager, the mode switch module 47924 may skip to step 48026. If the wager is not allowed to be a cash value wager, the mode switch module 47924 may switch, at step 48012, to non-cash value wager mode. Non-cash value wager mode may preclude wagering cash or any token with a cash value. The definitions of cash value and non-cash value may be jurisdiction-specific depending on the jurisdiction's laws. Cash value tokens may include credit, points redeemable in the jurisdiction for a cash value, airline miles, cryptocurrency, etc. The mode switch module 47924 may send, at step 48014, a notification to the mobile device 47908 that the user has been switched to non-cash value wagering mode. The notification may include a message that indicates why the mode has been switched, such as, “It is illegal to bet on a game of tennis in your current jurisdiction. You will still be able to place a bet for reward points.” The mode switch module 47924 may search, at step 48016, the responsible gaming database 47928 for a user ID that matches the user ID received from the mobile device 47908. The mode switch module 47924 may determine, at step 48018, if there is a match for the user ID in the responsible gaming database 47928. If there is no match, the mode switch module 47924 may skip to step 48026. If there is a match for the user ID in the responsible gaming database 47928, the mode switch module 47924 may determine, at step 48020, if the wager can be a cash value wager by checking the rule in the responsible gaming database 47928 associated with the matching user ID. The rule may indicate which types of wagers are not allowed to be cash value wagers. If the wager can be a cash value wager, the mode switch module 47924 may skip to step 48026. If the wager is not allowed to be a cash value wager, the mode switch module 47924 may switch, at step 48022, to non-cash value wager mode. Non-cash value wager mode may preclude wagering cash or any token with a cash value. Cash value tokens may include credit, points redeemable for a cash value, airline miles, cryptocurrency, etc. The mode switch module 47924 may send, at step 48024, a notification to the mobile device 47908 that the user has been switched to non-cash value wagering mode. The notification may include a message that indicates why the mode has been switched, such as, “You've gone over your own pre-set rule of ten cash value wagers within an hour. You will still be able to place a bet for reward points.” The mode switch module 47924 may return to step 48000, at step 48026.

FIG. 481 illustrates the jurisdiction database 47926. The jurisdiction database 47926, may contain jurisdictions and the associated legal rules on gambling. The jurisdiction database 47926 may contain a jurisdiction's name and an array of coordinates that correspond to that jurisdiction. The array of coordinates may be stored as a list or table of coordinates in a text file; for example, the coordinates for the jurisdiction of the state of Utah may be stored as “Utah.txt.” The jurisdiction database 47926 may also contain rules which list the types of wagers that are legal or illegal in the state.

FIG. 482 illustrates the responsible gaming database 47928. The responsible gaming database 47928 may contain user IDs and associated cash value wager rules set by an administrator, a module, or the user. The rules may include wagers on types of live events, such as baseball or tennis. The rules may disallow cash value wagers after a certain amount of wagers have been placed in a time limit, for example, ten wagers within an hour. The rules may be temporary; for example, the user may be excluded from making any cash value wager for 48 hours.

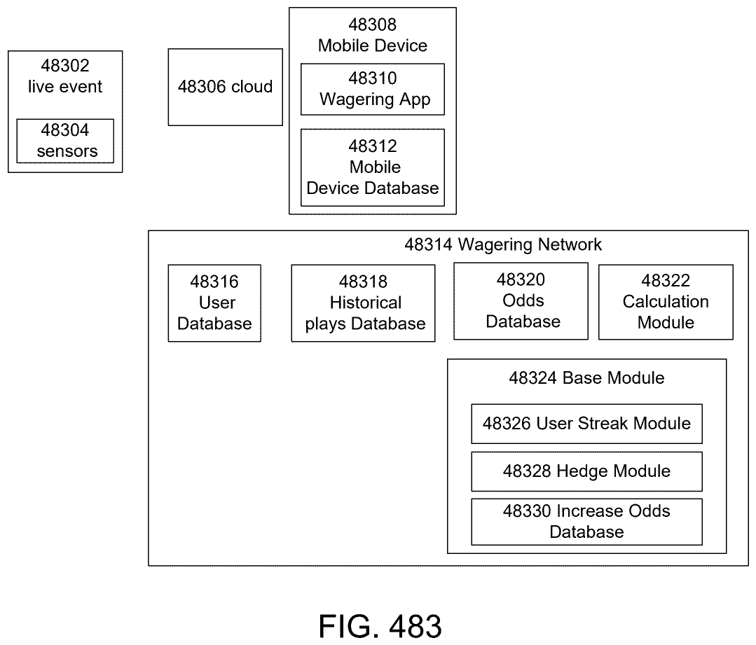

FIG. 483 illustrates a method for allowing a user to hedge their wagers, according to an embodiment.

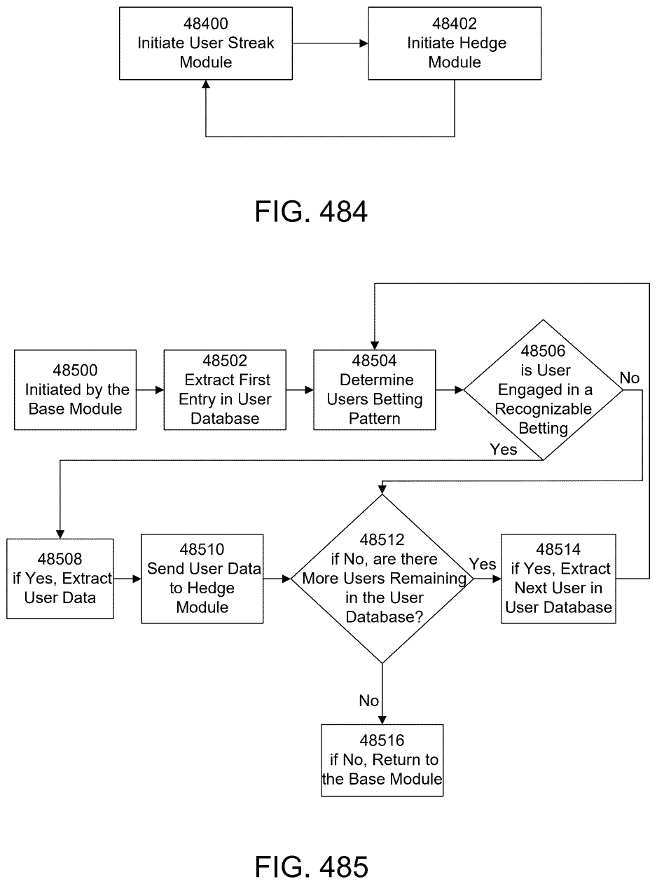

FIG. 484 illustrates a base module, according to an embodiment.

FIG. 485 illustrates a user streak module, according to an embodiment.

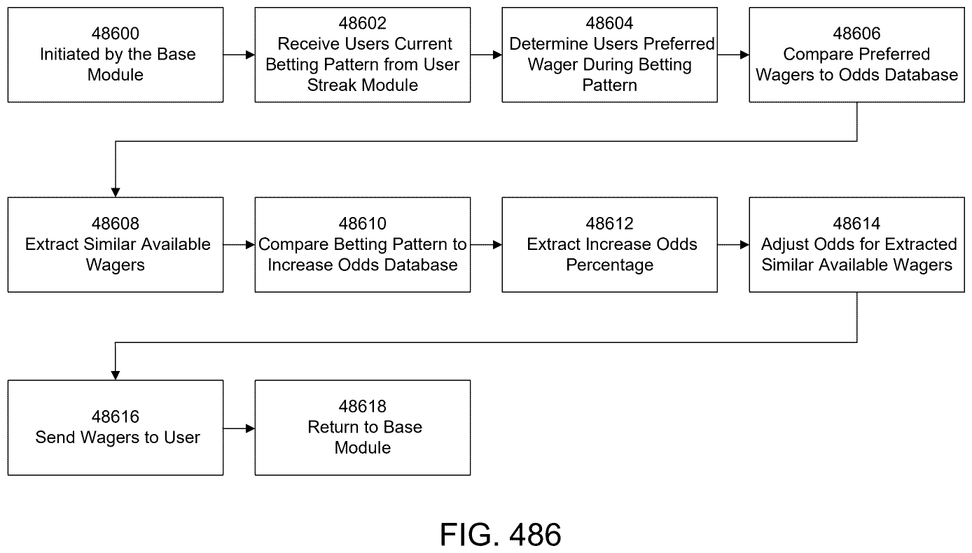

FIG. 486 illustrates a hedge module, according to an embodiment.

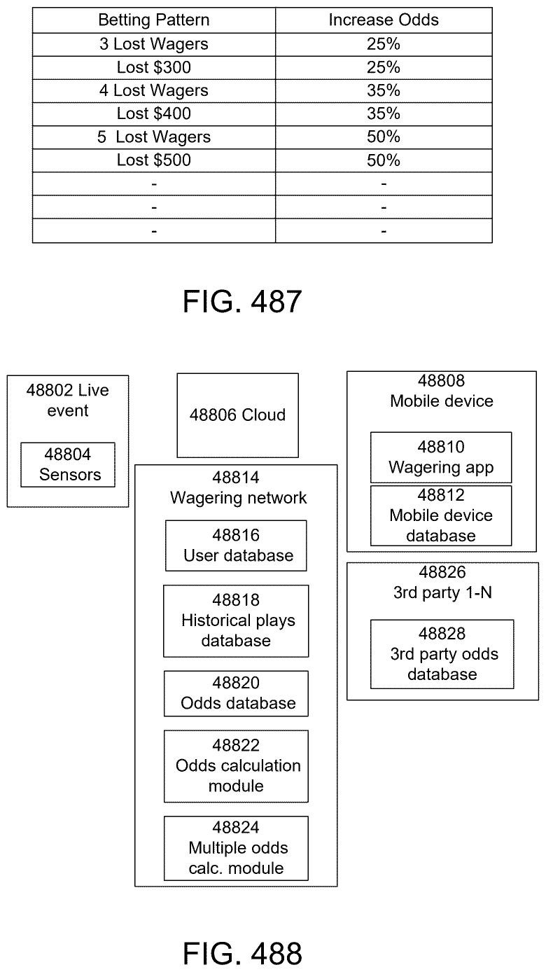

FIG. 487 illustrates an increase odds database, according to an embodiment.

FIG. 483 is a method for allowing a user to hedge their wagers. This system may include a live event 48302, for example, a sporting event such as a football, basketball, baseball, or hockey game, tennis match, golf tournament, eSports, or digital game, etc. The live event 48302 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team may need to cover if the result of the game with the same as the point spread the user may not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 48302, such as the score of an American football game or the run line in a baseball game, or a series of actions in the live event 48302. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 48302 or at another location.

Further, embodiments may include a plurality of sensors 48304 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 48304 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 48306 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 48306 may be communicatively coupled to a peer-to-peer wagering network 48314, which may perform real-time analysis on the type of play and the result of the play. The cloud 48306 may also be synchronized with game situational data such as the time of the game, the score, location on the field, weather conditions, and the like, which may affect the choice of play utilized. For example, in an exemplary embodiment, the cloud 48306 may not receive data gathered from the sensors 48304 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 48308 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 48308 could be an optional component and may be utilized in a situation where a paired wearable device employs the mobile device 48308 for additional memory or computing power or connection to the internet.

Further, embodiments may include a wagering software application or a wagering app 48310, which is a program that enables the user to place bets on individual plays in the live event 48302, streams audio and video from the live event 48302, and features the available wagers from the live event 48302 on the mobile device 48308. The wagering app 48310 allows the user to interact with the wagering network 48314 to place bets and provide payment/receive funds based on wager outcomes.

Further, embodiments may include a mobile device database 48312 that may store some or all the user's data, the live event 48302, or the user's interaction with the wagering network 48314.

Further, embodiments may include the wagering network 48314, which may perform real-time analysis on the type of play and the result of a play or action. The wagering network 48314 (or the cloud 48306) may also be synchronized with game situational data, such as the time of the game, the score, location on the field, weather conditions, and the like, which may affect the choice of play utilized. For example, in an exemplary embodiment, the wagering network 48314 may not receive data gathered from the sensors 48304 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 48314 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 48316, which may contain data relevant to all users of the wagering network 48314 and may include, but is not limited to, a user ID, a device identifier, a paired device identifier, wagering history, or wallet information for the user. The user database 48316 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 48316 may contain betting lines and search queries. The user database 48316 may be searched based on a search criterion received from the user. Each betting line may include but is not limited to, a plurality of betting attributes such as at least one of the following: the live event 48302, a team, a player, an amount of wager, etc. The user database 48316 may include, but is not limited to, information related to all the users involved in the live event 48302. In one exemplary embodiment, the user database 48316 may include information for generating a user authenticity report and a wagering verification report. Further, the user database 48316 may be used to store user statistics like, but not limited to, the retention period for a particular user, frequency of wagers placed by a particular user, the average amount of wager placed by each user, etc.

Further, embodiments may include a historical plays database 48318 that may contain play data for the type of sport being played in the live event 48302. For example, in American Football, for optimal odds calculation, the historical play data may include metadata about the historical plays, such as time, location, weather, previous plays, opponent, physiological data, etc.

Further, embodiments may utilize an odds database 48320—that may contain the odds calculated by an odds calculation module 48322—to display the odds on the user's mobile device 48308 and take bets from the user through the mobile device wagering app 48310.

Further, embodiments may include the odds calculation module 48322, which may utilize historical play data to calculate odds for in-play wagers.

Further, embodiments may include a base module 48324, which may initiate the user streak module 48326. For example, the user streak module 48326 may extract the first entry in user database 48316 and determine the user's current win or loss streak. Then the user streak module 48326 may determine if the user is on a losing streak, and if it may be determined that there is a pattern in the user's betting behavior, then the user streak module 48326 may extract the user data stored in the user database 48316. Then the user streak module 48326 may send the user data to the hedge module 48328. If the user is not demonstrating a pattern in their betting behavior, then the user streak module 48326 may determine if more users are remaining in the user database 48316. If more users are remaining in the user database 48316, then the user streak module 48326 may extract the next user in the user database 48316, and the process may continue to determine the user's current win or loss streak. If there are no more users remaining in the user database 48316, then the user streak module 48326 may return to the base module 48324. Then the base module 48324 may initiate the hedge module 48328. For example, the hedge module 48328 may receive the current user betting pattern from the user streak module 48326. The hedge module 48328 may determine the user's preferred wager during the identified betting pattern and compare the preferred wagers to the odds database 48320. The hedge module 48328 may extract similar available wagers in the odds database 48320 and compare the user's current betting pattern to the increase odds database 48330. The hedge module 48328 may extract the increased odds percentage stored in the increase odds database 48330 and adjust the odds for the extracted similar wagers based on the extracted percentage from the increase odds database 48330. The hedge module 48328 may send the wagers with the increased odds to the user and may return to the base module 48324.

Further, embodiments may include a user streak module 48326, which may extract the first entry in user database 48316. For example, the user streak module 48326 may extract the first user in the user database 48316, including the user's wagering history. Then the user streak module 48326 may determine the user's current win or loss streak. For example, the user streak module 48326 may begin at the user's latest wager result stored in the user database 48316, and for every wager lost, the user streak module 48326 may count one until the result is a win and the user streak module may add the counted ones to determine the user betting pattern. For example, if the user has the wagering history of lost, lost, lost, win, then the three losses may be counted as three, and the count may stop at the win if the user's latest wager result is a win the losing streak is counted as zero. Then the user streak module 48326 may determine if the user is demonstrating a recognized pattern in their betting behavior. For example, if the user exceeds a predetermined threshold, such as three consecutive losses, the user may be determined to be engaging in a recognized pattern in their betting behavior. If the user is engaging in a recognized pattern in their betting behavior, then the user streak module 48326 may extract the user data stored in the user database 48316. For example, the user's data from the betting pattern may be extracted, such as the user ID, the event, the wagering market, the wager, the total dollar amount wagered, etc. Then the user streak module 48326 may send the user data to the hedge module 48328. For example, the user's data from the betting pattern may be sent to the hedge module 48328, such as the user ID, the event, the wagering market, the wager, the total dollar amount wagered, the betting pattern, etc. If the user is not engaging in a recognized pattern in their betting behavior, then the user streak module 48326 may determine if more users are remaining in the user database 48316. For example, if the user has the wagering history of lost, lost, lost, win, then the three losses may be counted as three, and the count may stop at the win if the user's latest wager result is a win the losing streak is counted as zero. If more users are remaining in the user database 48316, then the user streak module 48326 may extract the next user in the user database 48316, and the process may continue to determine the user's current betting pattern. If there are no more users remaining in the user database 48316, then the user streak module 48326 may return to the base module 48324. While the example of a recognizable betting pattern is a losing streak, an artificial intelligence may be applied to a user's wagering history to identify patterns in wagering behavior that are correlated with specific behaviors in a user or cohort of similar users. For example, a user may have a tendency to stop wagering after winning a wager that brings them back to even for a given game. The system may identify this tendency and offer more attractive odds to entice the user to stay engaged.

Further, embodiments may include a hedge module 48328, which may receive the current recognized betting pattern from the user streak module 48326. For example, the user's data from the recognized betting pattern may be received by hedge module 48328, such as the user ID, the event, the wagering market, the wager, the total dollar amount wagered, the losing streak number, etc. The hedge module 48328 may determine the user's preferred wager during the recognized betting pattern. For example, the hedge module 48328 may determine the types of wagers the user has made during the recognized betting pattern by analyzing the user's wagering history during the recognized betting pattern by finding the most reoccurring wager market during the recognized betting pattern. For example, if the user had wagered on the next play in the Kansas City Chiefs vs. Denver Broncos event may be a run three times and lost three consecutive times, then it may be determined that the user's preferred wager may be to wager on a run. Another example may be if the user's wagering history during the recognized betting pattern were on the next play in the New York Jets vs. the New England Patriots may be pass, pass, run, pass, then the most reoccurring wager may be for the next play to be a pass, and thus that is the user's preferred wager. Then the hedge module 48328 may compare the preferred wagers to the odds database 48320. For example, if the user's preferred wager is for the next play to be a run, the hedge module 48328 may filter the odds database 48320 for every wager that was available for the next play to be a run, such as the next play in the Las Vegas Raiders vs. the Seattle Seahawks may be a run with the wager odds of 4:1. The hedge module 48328 may extract the similar available wagers in the odds database 48320. For example, the hedge module 48328 may extract the next play in the Las Vegas Raiders vs. the Seattle Seahawks event which may be a run with the wager odds of 4:1 from the odds database 48320. Then the hedge module 48328 may compare the user's current recognized betting pattern to the increase odds database 48330. For example, the hedge module 48328 may compare the user's recognized betting pattern of three consecutive losses to the increase odds database 48330, which may have corresponding increase odds percentage of 25%. The hedge module 48328 may extract the increased odds percentage stored in the increase odds database 48330. For example, the hedge module 48328 may extract the corresponding increase odds percentage of 25%. Then the hedge module 48328 may adjust the odds for the extracted similar wagers based on the extracted percentage from the increase odds database 48330. For example, the hedge module 48328 may increase the odds of the next play in the Las Vegas Raiders vs. the Seattle Seahawks event which may be a run with the wager odds of 4:1 by the extracted 25%, creating new odds of 5:1 for the available wager. The hedge module 48328 may send the wagers with the increased odds to the user. For example, the hedge module 48328 may send the wager of the next play in the Las Vegas Raiders vs. the Seattle Seahawks event which may be a run with the wager odds of 6:1 to the user using the user ID. In some embodiments, the hedge module 48328 may send a list of available wagers to the user with increased odds to allow the user to have an option to select similar wagers in other events. Then the hedge module 48328 may return to the base module 48324.

Further, embodiments may include an increase odds database 48330. The database that may be used in the process described in the hedge module 48328 may determine how much the odds should be increased for the user. The database may contain the recognized betting pattern, sometimes in the form of a losing streak number, which may be consecutive losses, or a total dollar amount lost, and the percentage in which the odds should be increased for the similar wagers extracted from the user database 48316, such as by 25%, 35%, 50%, etc. For example, the hedge module 48328 may compare the user's recognized betting pattern of three consecutive losses to the increase odds database 48330, which may have corresponding increase odds percentage of 25%. In some embodiments, the odds may be increased by the user's skill level; for example, a beginner user may receive a different odds adjustment than an expert user to allow the beginner user to win back more money. Finally, in some embodiments, the odds may be increased only for wagers that require more action or more users on one side of a wager, for example, if one wager has 70% of users wagering on the next play in the Las Vegas Raiders vs. the Seattle Seahawks may be a pass. The only offered wager with increased odds may be for the next play in the Las Vegas Raiders vs. the Seattle Seahawks event which may be a run to get more users to wager on the play to be a run to allow for more even action on both sides of the wager.

FIG. 484 illustrates the base module 48324. The process may begin with the base module 48324 initiating, at step 4840, the user streak module 48326. For example, the user streak module 48326 may extract the first entry in user database 48316. For example, the user streak module 48326 may extract the first user in the user database 48316, including the user's wagering history. Then the user streak module 48326 may determine the user's current win or loss streak. For example, the user streak module 48326 may begin at the user's latest wager result stored in the user database 48316, and for every wager lost, the user streak module 48326 may count one until the result is a win and the user streak module may add the counted ones to determine the losing streak. For example, if the user has the wagering history of lost, lost, lost, win, then the three losses may be counted as three, and the count may stop at the win if the user's latest wager result is a win the losing streak is counted as zero. Then the user streak module 48326 may determine if the user is engaged in a recognizable betting pattern. For example, if the user exceeds a predetermined threshold, for example, three consecutive losses, then the user may be determined to be engaged in a recognizable betting pattern. If the user is engaged in a recognizable betting pattern, then the user streak module 48326 may extract the user data stored in the user database 48316. For example, the user's data from the losing streak may be extracted, such as the user ID, the event, the wagering market, the wager, the total dollar amount wagered, recognizable betting pattern, etc. Then the user streak module 48326 may send the user data to the hedge module 48328. For example, the user's data from the losing streak may be sent to the hedge module 48328, such as the user ID, the event, the wagering market, the wager, the total dollar amount wagered, etc. If the user is not engaged in a recognizable betting pattern, then the user streak module 48326 may determine if more users are remaining in the user database 48316. For example, if the user has the wagering history of lost, lost, lost, win, then the three losses may be counted as three, and the count may stop at the win if the user's latest wager result is a win the losing streak is counted as zero. If more users are remaining in the user database 48316, then the user streak module 48326 may extract the next user in the user database 48316, and the process may continue to determine the user's current recognizable betting pattern. If there are no more users remaining in the user database 48316, then the user streak module 48326 may return to the base module 48324. Then the base module 48324 may initiate, at step 48402, the hedge module 48328. For example, the hedge module 48328 may receive the current recognizable betting pattern from the user streak module 48326. For example, the user's data from the recognizable betting pattern may be received by hedge module 48328, such as the user ID, the event, the wagering market, the wager, the total dollar amount wagered, the losing streak number, etc. The hedge module 48328 may determine the user's preferred wager during the recognizable betting pattern. For example, the hedge module 48328 may determine the types of wagers the user has made during the recognizable betting pattern by analyzing the user's wagering history during the recognizable betting pattern by finding the most reoccurring wager market during the recognizable betting pattern. For example, if the user had wagered on the next play in the Kansas City Chiefs vs. Denver Broncos event may be a run three times and lost three consecutive times, then it may be determined that the user's preferred wager may be to wager on a run. Another example may be if the user's wagering history during the recognizable betting pattern were on the next play in the New York Jets vs. the New England Patriots may be pass, pass, run, pass, then the most reoccurring wager may be for the next play to be a pass, and thus that is the user's preferred wager. Then the hedge module 48328 may compare the preferred wagers to the odds database 48320. For example, if the user's preferred wager is for the next play to be a run, the hedge module 48328 may filter the odds database 48320 for every wager that was available for the next play to be a run, such as the next play in the Las Vegas Raiders vs. the Seattle Seahawks may be a run with the wager odds of 4:1. The hedge module 48328 may extract the similar available wagers in the odds database 48320. For example, the hedge module 48328 may extract the next play in the Las Vegas Raiders vs. the Seattle Seahawks may be a run with the wager odds of 4:1 from the odds database 48320. Then the hedge module 48328 may compare the user's current pattern of betting behavior to the increase odds database 48330. For example, the hedge module 48328 may compare the user's recognizable betting pattern of three consecutive losses to the increase odds database 48330, which may have corresponding increase odds percentage of 25%. The hedge module 48328 may extract the increased odds percentage stored in the increase odds database 48330. For example, the hedge module 48328 may extract the corresponding increase odds percentage of 25%. Then the hedge module 48328 may adjust the odds for the extracted similar wagers based on the extracted percentage from the increase odds database 48330. For example, the hedge module 48328 may increase the odds of the next play in the Las Vegas Raiders vs. the Seattle Seahawks may be a run with the wager odds of 4:1 by the extracted 25%, creating new odds of 5:1 for the available wager. The hedge module 48328 may send the wagers with the increased odds to the user. For example, the hedge module 48328 may send the wager of the next play in the Las Vegas Raiders vs. the Seattle Seahawks may be a run with the wager odds of 6:1 to the user using the user ID. In some embodiments, the hedge module 48328 may send a list of available wagers to the user with increased odds to allow the user to have an option to select similar wagers in other events. Then the hedge module 48328 may return to the base module 48324.

FIG. 485 illustrates the user streak module 48326. The process may begin with the user streak module 48326 being initiated, at step 48500, by the base module 48324. The user streak module 48326 may extract, at step 48502, the first entry in user database 48316. For example, the user streak module 48326 may extract the first user in the user database 48316, including the user's wagering history. Then the user streak module 48326 may determine, at step 48504, the user's current betting pattern. For example, the user streak module 48326 may begin at the user's latest wager result stored in the user database 48316, and for every wager lost, the user streak module 48326 may count one until the result is a win and the user streak module may add the counted ones to determine the betting pattern. For example, if the user has the wagering history of lost, lost, lost, win, then the three losses may be counted as three, and the count may stop at the win if the user's latest wager result is a win the losing streak is counted as zero. Then the user streak module 48326 may determine, at step 48506, if the user is engaged in recognizable betting pattern. For example, if the user exceeds a predetermined threshold, for example, three consecutive losses, then the user may be determined to be engaged in a recognizable betting pattern. If the user is engaged in a recognizable betting pattern, then the user streak module 48326 may extract, at step 48508, the user data stored in the user database 48316. For example, the user's data from the betting pattern may be extracted, such as the user ID, the event, the wagering market, the wager, the total dollar amount wagered, etc. Then the user streak module 48326 may send, at step 48510, the user data to the hedge module 48328. For example, the user's data from the betting pattern may be sent to the hedge module 48328, such as the user ID, the event, the wagering market, the wager, the total dollar amount wagered, betting pattern, the losing streak number, etc. If the user is not engaged in a recognizable betting pattern, then the user streak module 48326 may determine, at step 48512, if more users are remaining in the user database 48316. For example, if the user has the wagering history of lost, lost, lost, win, then the three losses may be counted as three, and the count may stop at the win if the user's latest wager result is a win the losing streak is counted as zero. If more users are remaining in the user database 48316, then the user streak module 48326 may extract, at step 48514, the next user in the user database 48316, and the process may continue to determine the user's current betting pattern. If there are no more users remaining in the user database 48316, then the user streak module 48326 may return, at step 48516, to the base module 48324.

FIG. 486 illustrates the hedge module 48328. The process may begin with the base module 48324 initiating, at step 48600, the hedge module 48328. Then the hedge module 48328 may receive, at step 48602, the current betting pattern from the user streak module 48326. For example, the user's data from the betting pattern may be received by hedge module 48328, such as the user ID, the event, the wagering market, the wager, the total dollar amount wagered, the betting pattern, the losing streak number, etc. The hedge module 48328 may determine, at step 48604, the users preferred wager during the recognizable betting pattern. For example, the hedge module 48328 may determine the types of wagers the user has made during the recognizable betting pattern by analyzing the user's wagering history during the recognizable betting pattern by finding the most reoccurring wager market during the losing streak. For example, if the user had wagered on the next play in the Kansas City Chiefs vs. Denver Broncos event may be a run three times and lost three consecutive times, then it may be determined that the user's preferred wager may be to wager on a run. Another example may be if the user's wagering history during the recognizable betting pattern were on the next play in the New York Jets vs. the New England Patriots may be pass, pass, run, pass, then the most reoccurring wager may be for the next play to be a pass, and thus that is the user's preferred wager. Then the hedge module 48328 may compare, at step 48606, the preferred wagers to the odds database 48320. For example, if the user's preferred wager is for the next play to be a run, the hedge module 48328 may filter the odds database 48320 for every wager that was available for the next play to be a run, such as the next play in the Las Vegas Raiders vs. the Seattle Seahawks may be a run with the wager odds of 4:1. The hedge module 48328 may extract, at step 48608, the similar available wagers in the odds database 48320. For example, the hedge module 48328 may extract the next play in the Las Vegas Raiders vs. the Seattle Seahawks may be a run with the wager odds of 4:1 from the odds database 48320. Then the hedge module 48328 may compare, at step 48610, the user's current recognizable betting pattern to the increase odds database 48330. For example, the hedge module 48328 may compare the user's recognizable betting pattern of three consecutive losses to the increase odds database 48330, which may have corresponding increase odds percentage of 25%. The hedge module 48328 may extract, at step 48612, the increase odds percentage stored in the increase odds database 48330. For example, the hedge module 48328 may extract the corresponding increase odds percentage of 25%. Then the hedge module 48328 may adjust, at step 48614, the odds for the extracted similar wagers based on the extracted percentage from the increase odds database 48330. For example, the hedge module 48328 may increase the odds of the next play in the Las Vegas Raiders vs. the Seattle Seahawks may be a run with the wager odds of 4:1 by the extracted 25%, creating new odds of 5:1 for the available wager. The hedge module 48328 may send, at step 48616, the wagers with the increased odds to the user. For example, the hedge module 48328 may send the wager of the next play in the Las Vegas Raiders vs. the Seattle Seahawks may be a run with the wager odds of 6:1 to the user using the user ID. In some embodiments, the hedge module 48328 may send a list of available wagers to the user with increased odds to allow the user to have an option to select similar wagers in other events. Then the hedge module 48328 may return, at step 48618, to the base module 48324.

FIG. 487 illustrates the increase odds database 48330. The database may be used in the process described in the hedge module 48328 to determine how much the odds should be increased for the user. The database may contain the recognizable betting pattern, such as a losing streak number, which may be consecutive losses, or a total dollar amount lost, and the percentage in which the odds should be increased for the similar wagers extracted from the odds database 48316, such as by 25%, 35%, 50%, etc. For example, the hedge module 48328 may compare the user's recognizable betting pattern of three consecutive losses to the increase odds database 48330, which may have corresponding increase odds percentage of 25%. In some embodiments, the odds may be increased by the user's skill level; for example, a beginner user may receive a different odds adjustment than an expert user to allow the beginner user to win back more money. In some embodiments, the odds may be increased only for wagers that require more action or more users on one side of a wager, for example, if one wager has 70% of users wagering on the next play in the Las Vegas Raiders vs. the Seattle Seahawks may be a pass. The only offered wager with increased odds may be for the next play in the Las Vegas Raiders vs. the Seattle Seahawks may be a run to get more users to wager on the play to be run to allow for more even action on both sides of the wager.

FIG. 488 illustrates a system for odds calculation using multiple data sources, according to an embodiment.

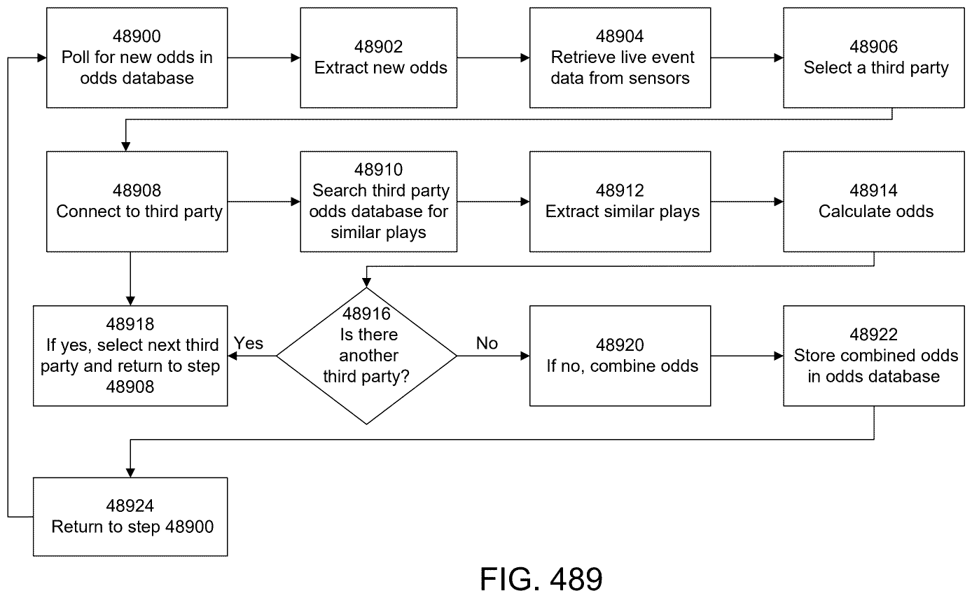

FIG. 489 illustrates a multiple odds calculation module, according to an embodiment.

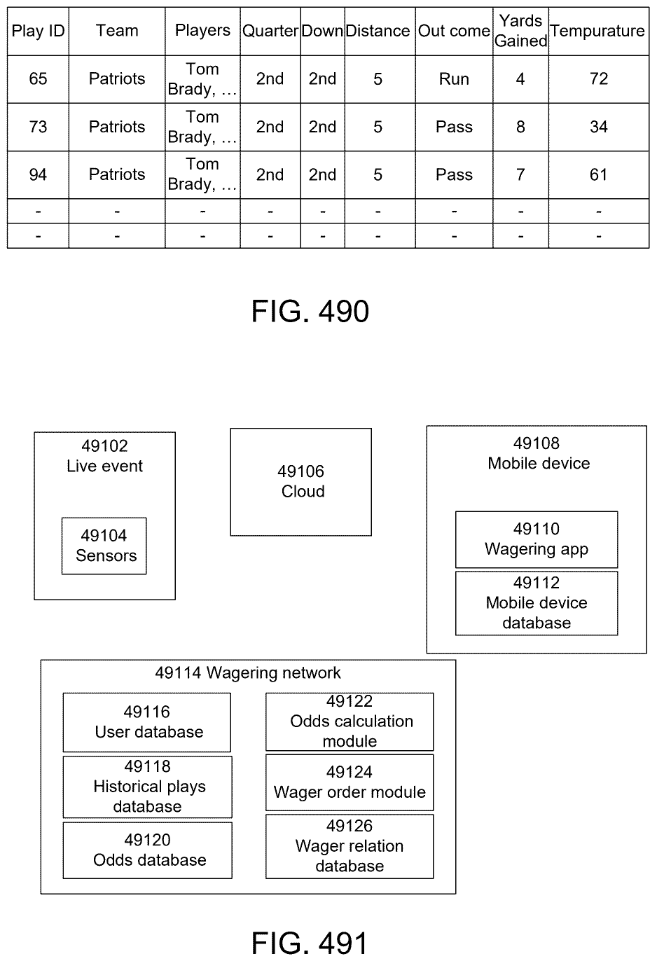

FIG. 490 illustrates a 3rd party odds database, according to an embodiment.

FIG. 488 is a system for odds calculation using multiple data sources. This system may include a live event 48802, for example, a sporting event such as a football, basketball, baseball, or hockey game, tennis match, golf tournament, eSports, or digital game, etc. The live event 48802 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 48802, such as the score of an American football game or the run line in a baseball game, or a series of actions in the live event 48802. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 48802 or at another location.

Further, embodiments may include a plurality of sensors 48804 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 48804 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 48806 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 48806 may be communicatively coupled to a peer-to-peer wagering network 48814, which may perform real-time analysis on the type of play and the result of the play. The cloud 48806 may also be synchronized with game situational data such as the time of the game, the score, location on the field, weather conditions, and the like, which may affect the choice of play utilized. For example, in an exemplary embodiment, the cloud 48806 may not receive data gathered from the sensors 48804 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 48808 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 48808 could be an optional component and would be utilized in a situation where a paired wearable device employs the mobile device 48808 for additional memory or computing power or connection to the internet.

Further, embodiments may include a wagering software application or a wagering app 48810, which is a program that enables the user to place bets on individual plays in the live event 48802, streams audio and video from the live event 48802, and features the available wagers from the live event 48802 on the mobile device 48808. The wagering app 48810 allows the user to interact with the wagering network 48814 to place bets and provide payment/receive funds based on wager outcomes.

Further, embodiments may include a mobile device database 48812 that may store some or all the user's data, the live event 48802, or the user's interaction with the wagering network 48814.

Further, embodiments may include the wagering network 48814, which may perform real-time analysis on the type of play and the result of a play or action. The wagering network 48814 (or the cloud 48806) may also be synchronized with game situational data, such as the time of the game, the score, location on the field, weather conditions, and the like, which may affect the choice of play utilized. For example, in an exemplary embodiment, the wagering network 48814 may not receive data gathered from the sensors 48804 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 48814 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 48816, which may contain data relevant to all users of the wagering network 48814 and may include, but is not limited to, a user ID, a device identifier, a paired device identifier, wagering history, or wallet information for the user. The user database 48816 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 48816 may contain betting lines and search queries. The user database 48816 may be searched based on a search criterion received from the user. Each betting line may include but is not limited to, a plurality of betting attributes such as at least one of the following: the live event 48802, a team, a player, an amount of wager, etc. The user database 48816 may include, but is not limited to, information related to all the users involved in the live event 48802. In one exemplary embodiment, the user database 48816 may include information for generating a user authenticity report and a wagering verification report. Further, the user database 48816 may be used to store user statistics like, but not limited to, the retention period for a particular user, frequency of wagers placed by a particular user, the average amount of wager placed by each user, etc.

Further, embodiments may include a historical plays database 48818 that may contain play data for the type of sport being played in the live event 48802. For example, in American Football, for optimal odds calculation, the historical play data may include metadata about the historical plays, such as time, location, weather, previous plays, opponent, physiological data, etc.

Further, embodiments may utilize an odds database 48820—that may contain the odds calculated by an odds calculation module 48822—to display the odds on the user's mobile device 48808 and take bets from the user through the mobile device wagering app 48810.

Further, embodiments may include the odds calculation module 48822, which may utilize historical play data to calculate odds for in-play wagers.

Further, embodiments may include a multiple odds calculation module 48824, which may connect to a third party 48826 or parties and collect data from each third-party odds database 48828. This data may then be used to adjust or replace the odds calculated by the odds calculation module 48822. For example, averaging the odds from all third parties 48826 and the odds calculation module 48822, selecting odds based on which dataset has the most data points, selecting odds based on which odds are most profitable, etc.

Further, embodiments may include a number of third parties 48826, which may be any entity that collects, analyzes, stores, or otherwise has access to a third-party odds database 48828 with historical data relevant to odds calculation.

Further, embodiments may include a third-party odds database 48828, which may contain data collected by a third party 48826, which may be relevant to calculating odds for wagering on the live event 48802. The third-party odds database may contain, for example, play data, weather data, data on wagers placed, data on odds given for wagers, data on bettor behavior, data on account balances, etc.

FIG. 489 illustrates the multiple odds calculation module 48824. The process may begin with the multiple odds calculation module 48824 polling, at step 48900, for new odds in the odds database 48820. These new odds may have been calculated by the odds calculation module 48822 from data on the current state of the live event 48802. The multiple odds calculation module 48824 may extract, at step 48902, the new odds from the odds database 48820. The multiple odds calculation module 48824 may retrieve, at step 48904, data on the live event 48802 from the sensors 48804. This data may be reflective of the current play of the live event 48802. The multiple odds calculation module 48824 may select, at step 48906, a third-party entity 48826. If there is only one third-party entity 48826, this step may be skipped. The multiple odds calculation module 48824 may connect, at step 48908, to the selected third party 48826. The multiple odds calculation module 48824 may search, at step 48910, the third-party odds database 48828 for plays with parameters similar to the current play of the live event 48802. Similar may not have to be an exact match. For example, two plays with the same team and players may be similar even though the weather may differ. Which plays are considered similar may be adjusted by an administrator of the system or another module. The multiple odds calculation module 48824 may extract, at step 48912, similar plays from the third-party odds database 48828. The multiple odds calculation module 48824 may normalize, at step 48914, the relevant data from the extracted plays. Relevant data may refer to the data from which the odds will be determined. For example, if users are placing bets on the pitch speed of the next pitch in a baseball game, then the relevant data may be the pitch speed of the extracted plays. Normalize may mean discarding outliers in the dataset. For example, 100 similar plays are extracted from the third-party odds database 48828. The relevant data is the pitch speed of a baseball. The mean average from the extracted plays is 87 mph, and the standard deviation is 12 mph. The multiple odds calculation module may be configured to exclude plays with relevant data that falls outside of two standard deviations from the mean. One similar play has a pitch speed of 3 mph. This play may be excluded from the odds calculation. Which plays are excluded from the odds calculation may be set by an administrator of the system or another module. This normalization step may be skipped when the relevant data is a discrete outcome such as “run” vs. “pass” in American football. The multiple odds calculation module 48824 may calculate, at step 48916, odds for the outcome of the current play based on the extracted similar plays. For example, 100 similar plays are extracted. In 40 of those plays, a baseball was thrown with a pitch speed of above 90 mph, and in the other 60, the speed of the pitch was 90 mph or below. The odds for the pitch speed of the current play to be above 90 mph would then be calculated to be 40%, and the odds for the pitch speed to be 90 mph or below would be 60%. The third-party odds database 48828 may already contain calculated odds calculated by the third party 48826 for each play. The multiple odds calculation module 48824 may use these odds. For example, the multiple odds calculation module 48824 may average all similar plays or use the odds from the most similar play. The multiple odds calculation module 48824 may determine, at step 48918, if there is another third party 48826. If there is another third party 48826, the multiple odds calculation module 48824 may select, at step 48920, the next third party 48826 and return to step 48908. If there are no other third parties 48826, the multiple odds calculation module 48824 may combine, at step 48922, the odds from each third party 48826 and the odds calculation module 48822 by taking a weighted average. An administrator or another module may set the weight assigned to the odds from each third party 48826 and the odds from the odds calculation module 48822. The weights may be static or dynamic. The weights may reflect how accurate or relevant each third party 48826 is to the determination of odds for the outcome of a play. For example, third parties 48826 with large sample sizes may be given more weight than those with less. Third parties 48826 with more parameters in their datasets may be given more weight than those with less. Third parties 48826 that have better-predicted historical outcomes may be given more weight than those that have less. Third parties 48826 that specialize in data collection from one type of live event 48802 may be given more weight than those that collect data from all live events 48802. The multiple odds calculation module 48824 may store, at step 48924, the combined odds in the odds database 48820. The original odds calculated by the odds calculation module 48822 may be overwritten in this step. The multiple odds calculation module 48824 may return, at step 48926, to step 48900.

FIG. 490 illustrates the 3rd party odds database 48828. The third-party odds database 48828 may contain data on historical plays or events that took place within a live event 48802. For example, the third-party odds database 48828 may contain data on all plays made during a baseball game, every baseball game this season, all games of baseball on record, every game of American football, baseball, and basketball this season, etc. The third-party odds database may contain the outcome of a play or event; for example, the play had a pitch speed of 84 mph. The third-party odds database may contain other parameters that may be useful for comparing similar plays, for example, which team was playing, which players were playing, in which part of the live event 48802 did the play or event occur, what was the temperature when the play or event occurred, etc. Each third party 48826 may have a third-party odds database 48828 with different combinations of these parameters.

FIG. 491 illustrates a system for wager presentation order optimization, according to an embodiment.

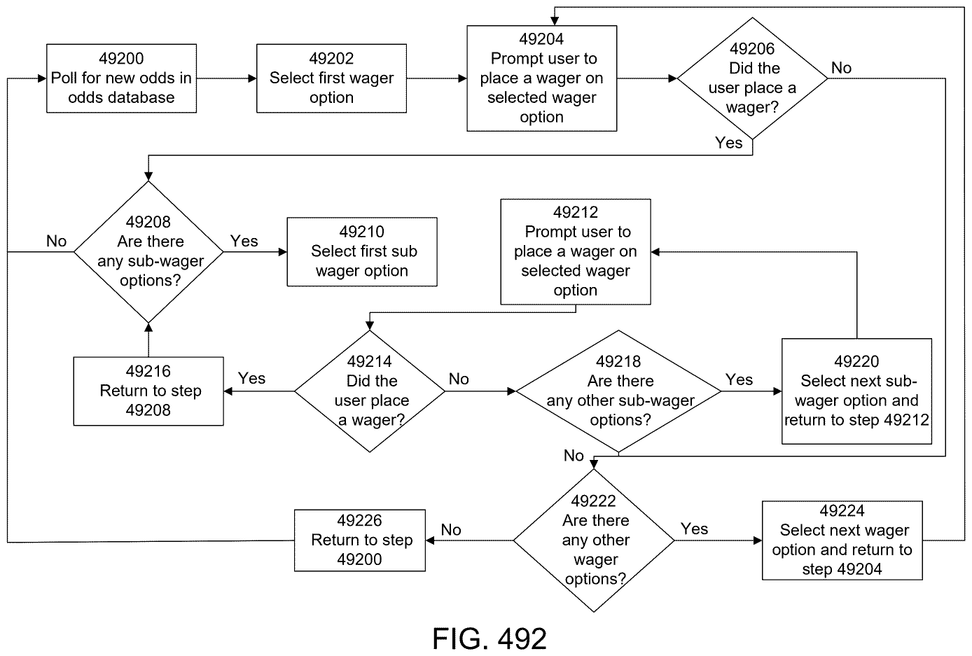

FIG. 492 illustrates a wager order module, according to an embodiment.

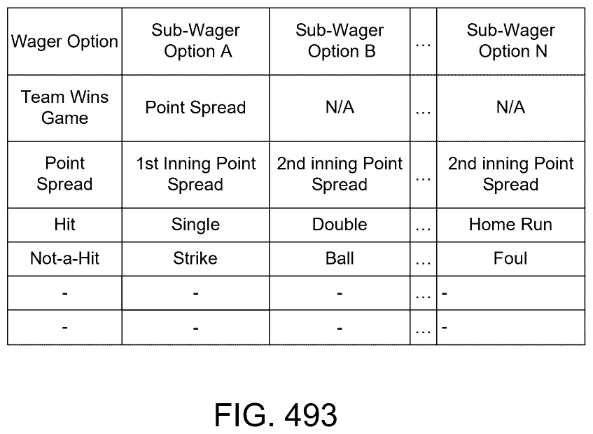

FIG. 493 illustrates a wager relation database, according to an embodiment.

FIG. 491 is a system for wager presentation order optimization. This system may include a live event 49102, for example, a sporting event such as a football, basketball, baseball, or hockey game, tennis match, golf tournament, eSports, or digital game, etc. The live event 49102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 49102, such as the score of an American football game or the run line in a baseball game, or a series of actions in the live event 49102. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 49102 or at another location.

Further, embodiments may include a plurality of sensors 49104 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 49104 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 49106 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 49106 may be communicatively coupled to a peer-to-peer wagering network 49114, which may perform real-time analysis on the type of play and the result of the play. The cloud 49106 may also be synchronized with game situational data such as the time of the game, the score, location on the field, weather conditions, and the like, which may affect the choice of play utilized. For example, in an exemplary embodiment, the cloud 49106 may not receive data gathered from the sensors 49104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 49108 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 49108 could be an optional component and would be utilized in a situation where a paired wearable device employs the mobile device 49108 for additional memory or computing power or connection to the internet.

Further, embodiments may include a wagering software application or a wagering app 49110, which is a program that enables the user to place bets on individual plays in the live event 49102, streams audio and video from the live event 49102, and features the available wagers from the live event 49102 on the mobile device 49108. The wagering app 49110 allows the user to interact with the wagering network 49114 to place bets and provide payment/receive funds based on wager outcomes.

Further, embodiments may include a mobile device database 49112 that may store some or all the user's data, the live event 49102, or the user's interaction with the wagering network 49114.

Further, embodiments may include the wagering network 49114, which may perform real-time analysis on the type of play and the result of a play or action. The wagering network 49114 (or the cloud 49106) may also be synchronized with game situational data, such as the time of the game, the score, location on the field, weather conditions, and the like, which may affect the choice of play utilized. For example, in an exemplary embodiment, the wagering network 49114 may not receive data gathered from the sensors 49104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 49114 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 49116, which may contain data relevant to all users of the wagering network 49114 and may include, but is not limited to, a user ID, a device identifier, a paired device identifier, wagering history, or wallet information for the user. The user database 49116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 49116 may contain betting lines and search queries. The user database 49116 may be searched based on a search criterion received from the user. Each betting line may include but is not limited to, a plurality of betting attributes such as at least one of the following: the live event 49102, a team, a player, an amount of wager, etc. The user database 49116 may include, but is not limited to, information related to all the users involved in the live event 49102. In one exemplary embodiment, the user database 49116 may include information for generating a user authenticity report and a wagering verification report. Further, the user database 49116 may be used to store user statistics like, but not limited to, the retention period for a particular user, frequency of wagers placed by a particular user, the average amount of wager placed by each user, etc.

Further, embodiments may include a historical plays database 49118 that may contain play data for the type of sport being played in the live event 49102. For example, in American Football, for optimal odds calculation, the historical play data may include metadata about the historical plays, such as time, location, weather, previous plays, opponent, physiological data, etc.

Further, embodiments may utilize an odds database 49120—that may contain the odds calculated by an odds calculation module 49122—to display the odds on the user's mobile device 49108 and take bets from the user through the mobile device wagering app 49110.

Further, embodiments may include the odds calculation module 49122, which may utilize historical play data to calculate odds for in-play wagers.

Further, embodiments may include a wager order module 49124, which may determine the order in which wager options may be shown to a user. This determination may include factors like the user's preferences, profit optimization, and which wager options are sub-options of other wager options.

Further, embodiments may include a wager relation database 49126, which may contain the relationship between wager options of different specificity. For example, in a baseball game, the result of a pitch could be a hit or not-a-hit, and each of these outcomes could be a wager option. However, the user could wager on a more specific wager option. For example, the hit is a home run or that the not-a-hit was a ball. These more specific wagers may be considered sub-wagers of the more general wagers and therefore may be associated.

FIG. 492 illustrates the wager order module 49124. The process may begin with the wager order module 49124 polling, at step 49200, for new odds in the odds database 49120. These new odds may be new odds for one wager option or multiple wager options. These new odds may be generated due to the changing state of the live event 49102. The wager order module 49124 may select, at step 49202, a first wager option. This option may be selected from a group of wagers that are not sub-wagers of other wagers. Which of these wagers is selected first may be based on which wager will optimize profit, which wagers the user may prefer based on past wagers, which team the user is likely to wager on, etc. User-specific data may be obtained from the user database 49116. The user database 49116 may contain user wager preferences based on the frequency that a user selects a wager option. User wager preferences may additionally or alternatively be entered manually by the user. Wager options on the same level may be displayed in an order based on this information. For example, the user may have the choice between wagering on the final score of the game, wagering on the final score of the current inning, and wagering on the outcome of the current play. The wager order module 49124 may check the user database 49116 to determine which of these options is most often selected by the user and display that option first. Then, the next most frequent may be selected, then the third most frequent etc. The preferred option may be based on more than frequency alone, for example the context of the game may influence the order in which wagers appear. For example, the user may frequently bet on the final score of the game in most situations, but when their favorite team is playing they tend to make wagers on the outcome of each play. This additional context may be recognized by the wager order module 49124. This context recognition may be facilitated by a learning algorithm or artificial intelligence module. The wager order module 49124 may prompt, at step 49204, the user to place a wager on the selected wager option. The wager order module 49124 may determine, at step 49206, if the user placed a wager. If the user did not place a wager, the wager order module 49124 might skip to step 49222. If the user placed a wager, the wager order module 49124 might determine, at step 49208, if there are any sub-wager options for the wager. The wager order module 49124 may search the wager relation database 49126 for the selected wager to determine if there are any sub-wager options. If there are no sub-wager options, then the wager order module 49124 may return to step 49200. If there are any sub-wager options, the wager order module 49124 may select, at step 49210, the first sub-wager option. Which of these sub-wager options is selected first may be based on which wager will optimize profit, which wagers the user may prefer based on past wagers, which team the user is likely to wager on, etc. User-specific data may be obtained from the user database 49116. The wager order module 49124 may prompt, at step 49212, the user to place a wager on the selected sub-wager option. The user may choose to keep the same amount wagered but choose the sub-wager option for a different set of odds than the more general wager option. The wager order module 49124 may determine, at step 49214, if a user placed a wager on the selected sub-wager option. If the user placed a wager, the wager order module 49124 might return, at step 49216, to step 49208. If the user did not place a wager, the wager order module 49124 might determine, at step 49218, if there are any other sub-wager options. If there is another sub-wager option, the wager order module 49124 may select, at step 49220, the next sub-wager option and return to step 49212. If there are no other sub-wager options, the wager order module 49124 may determine, at step 49222, if there are any other wager options. These may be the most broad wager options or sub-wager options that are still broader than the current specificity level. If there are other wager options, the wager order module 49124 may select, at step 49224, the next wager option and return to step 49204. The wager order module 49124 may return, at step 49226, to step 49200.

FIG. 493 illustrates the wager relation database 49126. The wager relation database 49126 may include several wager options associated based on the relationship between those options. For example, a “single” in baseball may be a sub-wager of a wager for a “hit” since all singles are hits, but not all hits are singles. These relationships may be based on the rules of the game. An algorithm may learn these relationships based on statistical user wager behavior.

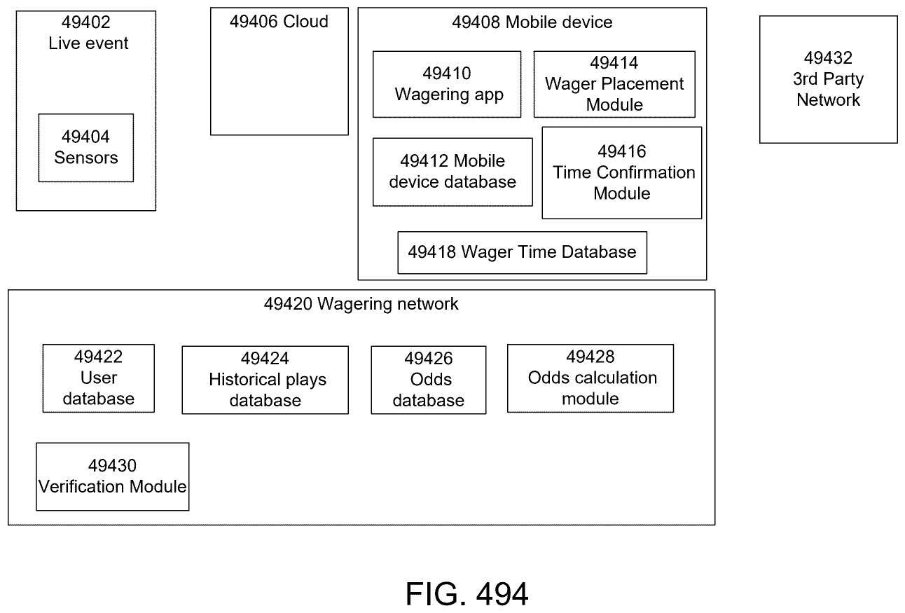

FIG. 494 illustrates a system for verifying that a wager was placed before market close on a play-by-play wagering network, according to an embodiment.

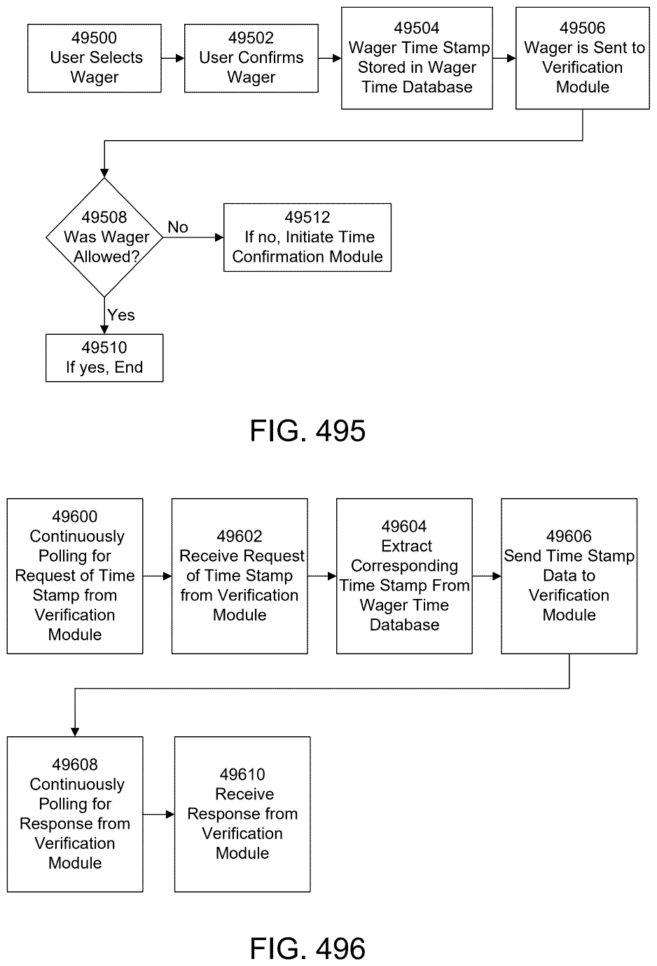

FIG. 495 illustrates a wager placement module, according to an embodiment.

FIG. 496 illustrates a time confirmation module, according to an embodiment.

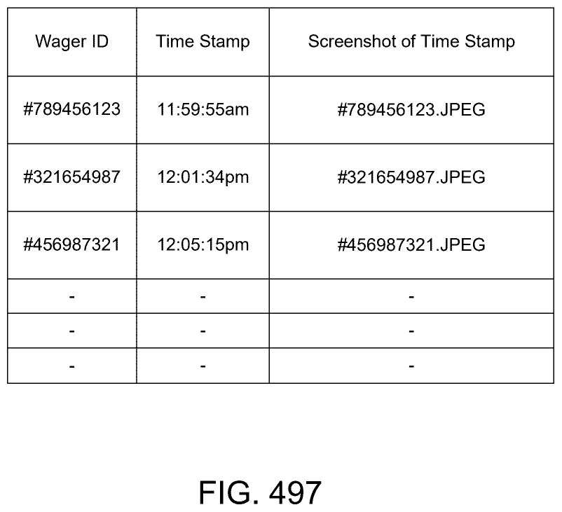

FIG. 497 illustrates a wager time database, according to an embodiment.

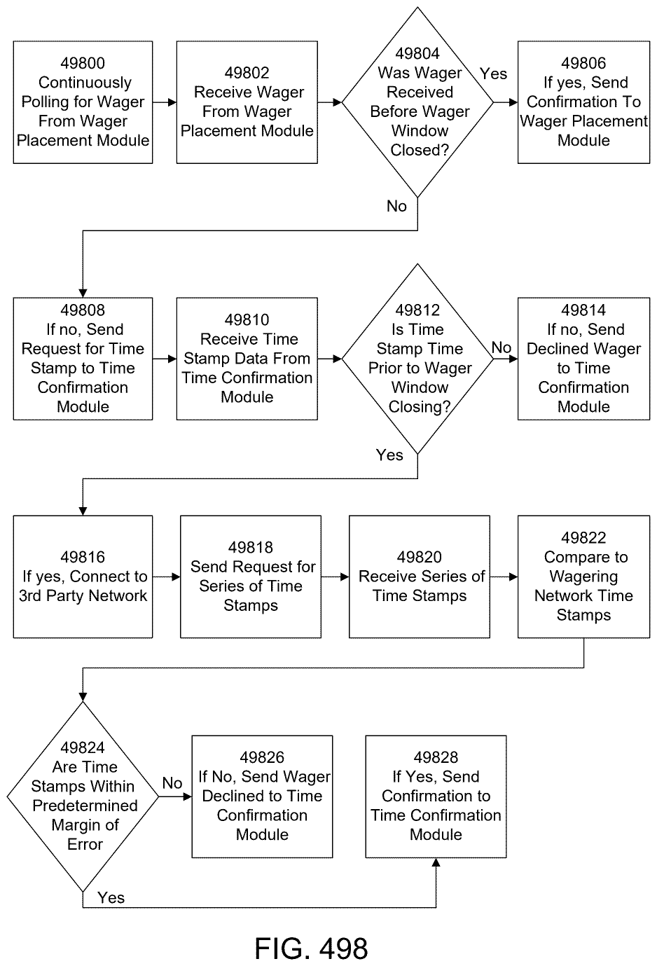

FIG. 498 illustrates a verification module, according to an embodiment.

FIG. 494 is a system for verifying that wager was placed before market close on a play-by-play wagering network. This system may include a live event 49402, for example, a sporting event such as a football, basketball, baseball, or hockey game, tennis match, golf tournament, eSports, or digital game, etc. The live event 49402 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 49402, such as the score of an American football game or the run line in a baseball game, or a series of actions in the live event 49402. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 49402 or at another location.

Further, embodiments may include a plurality of sensors 49404 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 49404 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 49406 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 49406 may be communicatively coupled to a peer-to-peer wagering network 49414, which may perform real-time analysis on the type of play and the result of the play. The cloud 49406 may also be synchronized with game situational data such as the time of the game, the score, location on the field, weather conditions, and the like, which may affect the choice of play utilized. For example, in an exemplary embodiment, the cloud 49406 may not receive data gathered from the sensors 49404 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 49408 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or

Thunderbolt buses. In some embodiments, the mobile device 49408 could be an optional component and would be utilized in a situation where a paired wearable device employs the mobile device 49408 for additional memory or computing power or connection to the internet.

Further, embodiments may include a wagering software application or a wagering app 49410, which is a program that enables the user to place bets on individual plays in the live event 49402, streams audio and video from the live event 49402, and features the available wagers from the live event 49402 on the mobile device 49408. The wagering app 49410 allows the user to interact with the wagering network 49420 to place bets and provide payment/receive funds based on wager outcomes.

Further, embodiments may include a mobile device database 49412 that may store some or all the user's data, the live event 49402, or the user's interaction with the wagering network 49420.

Further, embodiments may include a wager placement module 49414, which may begin with the user selecting a wager on the wagering app 49410. For example, the user may select that the first pitch of the Boston Red Sox vs. New York Yankees will be a strike at 11:59:55 am. Then the user may confirm a wager on the wagering app 49410. For example, the user may confirm the wager of the first pitch of the Boston Red Sox vs. New York Yankees will be a strike at 11:59:55 am. Then the wager placement module 49414 may store the wager time stamp in the wager time database 49418. For example, the wager ID number, such as #789456123, the time, such as 11:59:55 am, and a screenshot of the confirmed wager stored as a JPEG file, such as #789456123 JPEG. The wager placement module 49414 may send the wager to the verification module 49430. For example, the wager that the first pitch of the Boston Red Sox vs. New York Yankees will be a strike may be sent to the verification module 49430. Then the wager placement module 49414 may determine if the wager was allowed. For example, the wager placement module 49414 may receive a confirmation from the verification module 49430 if the wager is accepted, or the wager placement module 49414 may receive a notice that the wager has been declined or that more data is needed to confirm the wager. If the wager was accepted or confirmed by the verification module 49430, then the process ends. For example, the wager placement module 49414 may receive a confirmation from the verification module 49430 if the wager is accepted. If the wager was not accepted by the verification module 49430, then the wager placement module 49414 may initiate the time confirmation module 49416. For example, the wager placement module 49414 may receive a notice that the wager has been declined or that more data is needed to confirm the wager in which the wager placement module 49414 may initiate the time confirmation module 49416.

Further, embodiments may include a time confirmation module 49416, which may begin with the time confirmation module 49416 continuously polling for a request from the verification module 49430 for the timestamp of the wager. For example, if the wager is declined or more data is needed to confirm the wager, the verification module 49430 may send a request for the data stored in the time wager time database 49418. Then the time confirmation module 49416 may receive a request for the time stamp from the verification module 49430. In some embodiments, the verification module 49430 may send the wager ID to receive the correct wager timestamp data from the time confirmation module 49416. The time confirmation module 49416 may extract the time stamp from the wager time database 49418. For example, the time confirmation module 49416 may extract the wager ID, the time stamp, and the screenshot of the wager confirmation from the wager time database 49418. Then the time confirmation module 49416 may send the time stamp data to the verification module 49430. For example, the time confirmation module 49416 may send the wager ID, such as #789456123, the time stamp, such as 11:59:55 am, and the screenshot of the wager confirmation in a JPEG file, such as #789456123.JPEG. Then the time confirmation module 49416 may continuously poll for a response from the verification module 49430. For example, the time confirmation module 49416 is polling for the verification module 49430 to either confirm or accept the wager or decline or cancel the wager. Then the time confirmation module 49416 may receive a response from the verification module 49430. For example, the time confirmation module 49416 may receive that the wager is confirmed or accepted or declined or canceled.

Further, embodiments may include a wager time database 49418, which may contain the wager ID, such as #789456123, the time stamp, such as 11:59:55 am, and the screenshot of the wager confirmation in a JPEG file, such as #789456123.JPEG. This database may be created from the process described in the wager placement module 49414, which may take a screenshot of the wager once confirmed and stores the data in the wager time database 49418. In some embodiments, the screenshot may be stored as a picture, image, photo, or some other visual data that displays the user device's screen to show the time in which the wager was confirmed.

Further, embodiments may include the wagering network 49420, which may perform real-time analysis on the type of play and the result of a play or action. The wagering network 49420 (or the cloud 49406) may also be synchronized with game situational data, such as the time of the game, the score, location on the field, weather conditions, and the like, which may affect the choice of play utilized. For example, in an exemplary embodiment, the wagering network 49420 may not receive data gathered from the sensors 49404 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 49420 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 49422, which may contain data relevant to all users of the wagering network 49420 and may include, but is not limited to, a user ID, a device identifier, a paired device identifier, wagering history, or wallet information for the user. The user database 49422 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 49422 may contain betting lines and search queries. The user database 49422 may be searched based on a search criterion received from the user. Each betting line may include, but is not limited to, a plurality of betting attributes such as at least one of the live event 49402, a team, a player, an amount of wager, etc. The user database 49422 may include but is not limited to information related to all the users involved in the live event 49402. In one exemplary embodiment, the user database 49422 may include information for generating a user authenticity report and a wagering verification report. Further, the user database 49422 may be used to store user statistics like, but not limited to, the retention period for a particular user, frequency of wagers placed by a particular user, the average amount of wager placed by each user, etc.

Further, embodiments may include a historical plays database 49424 that may contain play data for the type of sport being played in the live event 49402. For example, in American Football, for optimal odds calculation, the historical play data may include metadata about the historical plays, such as time, location, weather, previous plays, opponent, physiological data, etc. Further, embodiments may utilize an odds database 49426—that may contain the odds calculated by an odds calculation module 49428—to display the odds on the user's mobile device 49408 and take bets from the user through the mobile device wagering app 49410.

Further, embodiments may include the odds calculation module 49428, which utilizes historical play data to calculate odds for in-play wagers.

Further, embodiments may include a verification module 49430, which may begin with the verification module 49430 continuously polling for a wager from the wager placement module 49414. Then the verification module 49430 may receive the wager from the wager placement module 49414. Then the verification module 49430 may determine if the wager was received before the wager window has closed. For example, the verification module 49430 may determine if the time in which the wager was received was before the wager closing, for example, the wager window closing at 12:00:00 pm. If the wager was received before the wager window closed, the verification module may send a confirmation to the wager placement module 49414. For example, the wager window closed at 12:00:00 pm, but the wager was received before 12:00:00 pm. If the wager was not received before the wager window closed, then the verification module 49430 may send a request for the wager timestamp data to the time confirmation module 49416. For example, if the wager was received at 12:00:10 pm and the wager window closed at 12:00:00 pm, the verification module 49430 may send a request for wager timestamp data. Then the verification module 49430 may receive the time stamp data from the time confirmation module 49416. For example, the verification module 49430 may receive the wager ID, such as #789456123, the time stamp, such as 11:59:55 am, and the screenshot of the wager confirmation in a JPEG file such as #789456123.JPEG from the time confirmation module 49416. The verification module 49430 may determine if the time stamp data time is before the wager window closes. For example, the wager window closed at 12:00:00 pm, but the time stamp data for the wager was 11:59:55 am. If the time stamp data time is after the wager window closing, then the verification module 49430 may send wager declined to the time confirmation module 49416. For example, if the wager timestamp data was for 12:00:10 pm and the wager window closed at 12:00:00, the wager may be declined. If the time stamp data time is before the wager window closing, then the verification module 49430 may connect to the 3rd party network 49432. For example, the wager window closed at 12:00:00 pm, but the time stamp data for the wager was 11:59:55 am the verification module 49430 may connect to the 3rd party network 49432. Then the verification module 49430 may send a request for a series of timestamps to the 3rd party network 49432. For example, the verification module 49430 may request when the user data was received to confirm the wager was sent to the 3rd party network; also, the verification module 49430 may request the 3rd party network 49432 to send timestamps or pings of timestamps at different times so that the verification module has various time stamps from the 3rd party network 49432. The verification module 49430 may receive a series of timestamps from the 3rd party network 49432. For example, the verification module 49430 may request when the user data was received to confirm the wager was sent to the 3rd party network; also, the verification module 49430 may request the 3rd party network 49432 to send timestamps or pings of timestamps at different times so that the verification module has various time stamps from the 3rd party network 49432. Then the verification module 49430 may compare the wagering network 49420 to the received timestamps from the 3rd party network 49432. For example, the verification module 49430 may receive time stamps or pings of timestamps at different times from the 3rd party network 49432 and may compare them to the time that the wager network 49420 has when the timestamps are received so that the verification module 49430 can determine if the 3rd party network 49432 timestamps arc correct or if they have been altered in any fashion. For example, if the 3rd party network 49432 sends a timestamp of 12:00:00 pm and the time for the wagering network 49420 is 12:00:05 pm, then the 5-second discrepancy may be due to a latency issue. However, if the 3rd party network 49432 sends a timestamp of 11:00:00 am, and the time for the wagering network 49420 is 12:00:05 pm, then the time stamps for the 3rd party network 49432 have been altered in some fashion. The verification module 49430 may determine if the timestamps are within a predetermined margin of error, for example, within 10 seconds. For example, if the 3rd party network 49432 sends a timestamp of 12:00:00 pm and the time for the wagering network 49420 is 12:00:05 pm, this may fall into the 10-second predetermined margin of error, and the discrepancy may be due to a latency or disconnection issue. However, if the 3rd party network 49432 sends a timestamp of 11:00:00 am, and the time for the wagering network 49420 is 12:00:05 pm, then this may be above the predetermined margin of error, and the wager may be declined or canceled. If the timestamps are not within the predetermined margin of error, then the verification module may send that the wager was declined to the time confirmation module 49416. If the time stamps were within the predetermined margin of error, then the verification module 49430 may send a wager confirmation to the time confirmation module 49416.

Further, embodiments may include a 3rd party network 49432 used by the mobile device 49408 to connect to the wagering network 49420 to place wagers. The 3rd party network 49432 may be a wired and/or a wireless network. The 3rd party network 49432, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The 3rd party network 49432 may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance.

FIG. 495 illustrates the wager placement module 49414. The process may begin with the user selecting, at step 49500, a wager on the wagering app 49410. For example, the user may select that the first pitch of the Boston Red Sox vs. New York Yankees will be a strike at 11:59:55 am. Then the user may confirm, at step 49502, a wager on the wagering app 49410. For example, the user may confirm the wager of the first pitch of the Boston Red Sox vs. New York Yankees will be a strike at 11:59:55 am. Then the wager placement module 49414 may store the wager time stamp, at step 49504, in the wager time database 49418. For example, the wager ID number, such as #789456123, the time, such as 11:59:55 am, and a screenshot of the confirmed wager stored as a JPEG file, such as #789456123.JPEG. The wager placement module 49414 may send, at step 49506, the wager to the verification module 49430. For example, the wager that the first pitch of the Boston Red Sox vs. New York Yankees will be a strike may be sent to the verification module 49430. Then the wager placement module 49414 may determine, at step 49508, if the wager was allowed. For example, the wager placement module 49414 may receive a confirmation from the verification module 149430 if the wager is accepted, or the wager placement module 49414 may receive a notice that the wager has been declined or that more data is needed to confirm the wager. If the wager was accepted or confirmed by the verification module 49430, then the process may end at step 49510. For example, the wager placement module 49414 may receive a confirmation from the verification module 49430 if the wager is accepted. If the wager was not accepted by the verification module 49430, then the wager placement module 49414 may initiate, at step 49512, the time confirmation module 49416. For example, the wager placement module 49414 may receive a notice that the wager has been declined or that more data is needed to confirm the wager in which the wager placement module 49414 may initiate the time confirmation module 49416.

FIG. 496 illustrates the time confirmation module 49416. The process may begin with the time confirmation module 49416 continuously polling, at step 49600, for a request from the verification module 49430 for the timestamp of the wager. For example, if the wager is declined or more data is needed to confirm the wager, the verification module 49430 may send a request for the data stored in the wager time database 49418. Then the time confirmation module 49416 may receive, at step 49602, a request for the time stamp from the verification module 49430. For example, if the wager is declined or more data is needed to confirm the wager, the verification module 49430 may send a request for the data stored in the wager time database 49418. In some embodiments, the verification module 49430 may send the wager ID to receive the correct wager timestamp data from the time confirmation module 49416. The time confirmation module 49416 may extract, at step 49604, the time stamp from the wager time database 49418. For example, the time confirmation module 49416 may extract the wager ID, the time stamp, and the screenshot of the wager confirmation from the wager time database 49418. Then the time confirmation module 49416 may send, at step 49606, the time stamp data to the verification module 49430. For example, the time confirmation module 49416 may send the wager ID, such as #789456123, the time stamp, such as 11:59:55 am, and the screenshot of the wager confirmation in a JPEG file, such as #789456123.JPEG. Then the time confirmation module 49416 may continuously poll, at step 49608, for a response from the verification module 49430. For example, the time confirmation module 49416 is polling for the verification module 49430 to either confirm or accept the wager or decline or cancel the wager. Then the time confirmation module 49416 may receive, at step 49610, a response from the verification module 49430. For example, the time confirmation module 49416 may receive that the wager is confirmed, accepted, declined, or canceled.

FIG. 497 illustrates the wager time database 49418. The database may contain the wager ID, such as #789456123, the time stamp, such as 11:59:55 am, and the screenshot of the wager confirmation in a JPEG file, such as #789456123.JPEG. This database may be created from the process described in the wager placement module 49414, which may take a screenshot of the wager once confirmed and stores the data in the wager time database 49418. In some embodiments, the screenshot may be stored as a picture, image, photo, or some other visual data that displays the user device's screen to show the time in which the wager was confirmed.

FIG. 498 illustrates the verification module 49430. The process may begin with the verification module 49430 continuously polling, at step 49800, for a wager from the wager placement module 49414. For example, the verification module 49430 may poll for a wager the user has confirmed, such as the first pitch of the Boston Red Sox vs. New York Yankees will be a strike at 11:59:55 am. Then the verification module 49430 may receive, at step 49802, the wager from the wager placement module 49416. For example, the verification module 49430 may receive a wager the user has confirmed, such as the first pitch of the Boston Red Sox vs. New York Yankees will be a strike at 11:59:55 am. Then the verification module 49430 may determine, at step 49804, if the wager was received before the wager window has closed. For example, the verification module 49430 may determine if the time in which the wager was received was before the wager closing, for example, the wager window closing at 12:00:00 pm. If the wager was received before the wager window closed, the verification module may send, at step 49806, a confirmation to the wager placement module 49416. For example, the wager window closed at 12:00:00 pm, but the wager was received before 12:00:00 pm. If the wager was not received before the wager window closed, then the verification module 49430 may send, at step 49808, a request for the wager timestamp data to the time confirmation module 49416. For example, if the wager was received at 12:00:10 pm and the wager window closed at 12:00:00 pm, the verification module 49430 may send a request for wager timestamp data. Then the verification module 49430 may receive, at step 49810, the time stamp data from the time confirmation module 49416. For example, the verification module 49430 may receive the wager ID, such as #789456123, the time stamp, such as 11:59:55 am, and the screenshot of the wager confirmation in a JPEG file such as #789456123.JPEG from the time confirmation module 49416. The verification module 49430 may determine, at step 49812, if the wager timestamp data time is before the wager window closing. For example, the wager window closed at 12:00:00 pm, but the time stamp data for the wager was 11:59:55 am. If the time stamp data time is after the wager window closing, then the verification module 49430 may send, at step 49814, that the wager was declined to the time confirmation module 49416. For example, if the wager timestamp data was for 12:00:10 pm and the wager window closed at 12:00:00, the wager may be declined. If the time stamp data time is before the wager window closing, then the verification module 49430 may connect, at step 49816, to the 3rd party network 49432. For example, the wager window closed at 12:00:00 pm, but the time stamp data for the wager was 11:59:55 am the verification module 49430 may connect to the 3rd party network 49432. Then the verification module 49430 may send, at step 49818, a request for a series of timestamps to the 3rd party network 49432. For example, the verification module 49430 may request when the user data to confirm the wager was sent to the 3rd party network; also, the verification module 49430 may request the 3rd party network 49432 to send timestamps or pings of timestamps at different times so that the verification module has various time stamps from the 3rd party network 49432. The verification module 49430 may receive, at step 49820, a series of timestamps from the 3rd party network 49432. For example, the verification module 49430 may request when the user data to confirm the wager was sent to the 3rd party network; also, the verification module 49430 may request the 3rd party network 49432 to send timestamps or pings of timestamps at different times so that the verification module has various time stamps from the 3rd party network 49432. Then the verification module 49430 may compare, at step 49822, the wagering network 49420 to the received timestamps from the 3rd party network 49432. For example, the verification module 49430 may receive time stamps or pings of timestamps at different times from the 3rd party network 49432 and may compare them to the time that the wagering network 49420 has when the timestamps are received so that the verification module 49430 can determine if the 3rd party network 49432 timestamps are correct or if they have been altered in any fashion. For example, if the 3rd party network 49432 may send a timestamp of 12:00:00 pm and the time for the wagering network 49420 is 12:00:05 pm, then the 5-second discrepancy may be due to a latency issue. However, if the 3rd party network 49432 sends a timestamp of 11:00:00 am, and the time for the wagering network 49420 is 12:00:05 pm, then the time stamps for the 3rd party network 49432 have been altered in some fashion. The verification module 49430 may determine, at step 49824, if the timestamps are within a predetermined margin of error, for example, within 10 seconds. For example, if the 3rd party network 49432 sends a timestamp to the verification module 49430 at 12:00:00 pm and the time for the wagering network 49420 is 12:00:05 pm, this may fall into the 10-second predetermined margin of error, and the discrepancy may be due to a latency or disconnection issue. However, if the 3rd party network 49432 may send a timestamp of 11:00:00 am, and the time for the wagering network 49420 is 12:00:05 pm, this may be above the predetermined margin of error, and the wager may be declined or canceled. If the timestamps are not within the predetermined margin of error, then the verification module may send, at step 49826, that the wager was declined to the time confirmation module 49416. If the timestamps were within the predetermined margin of error, then the verification module 49430 may send, at step 49828, a wager confirmation to the time confirmation module 49416.

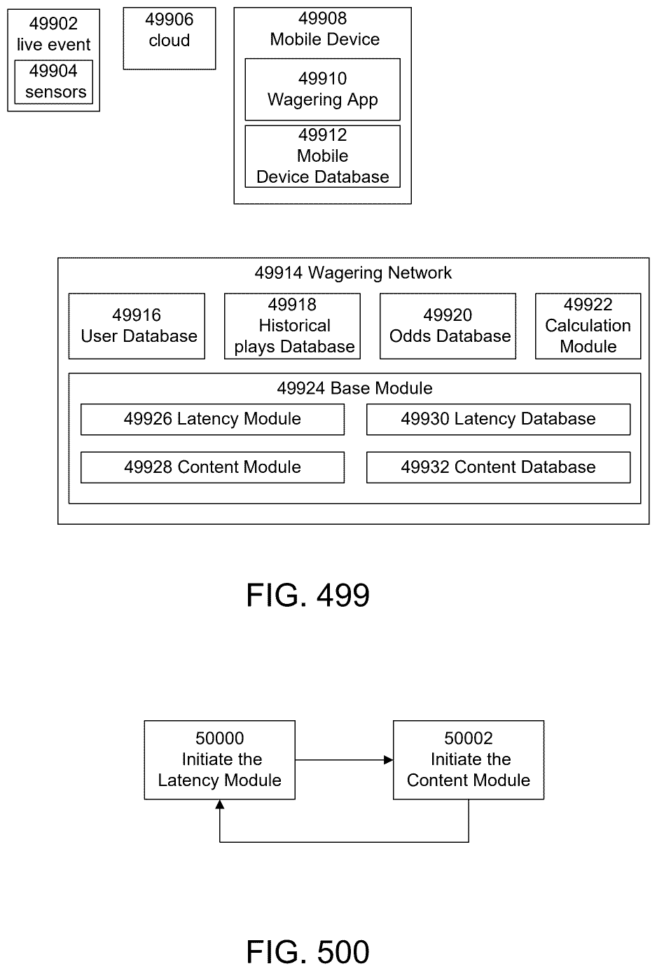

FIG. 499 illustrates a system for optimizing wagering on a wagering platform, according to an embodiment.

FIG. 500 illustrates a base module, according to an embodiment.

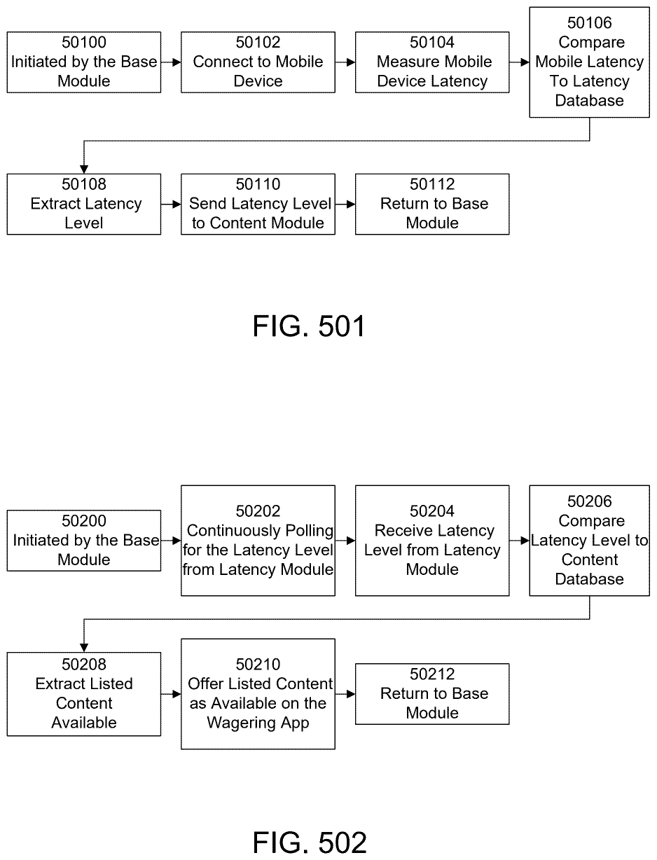

FIG. 501 illustrates a latency module, according to an embodiment.

FIG. 502 illustrates a content module according to an embodiment.

FIG. 503 illustrates a latency database, according to an embodiment.

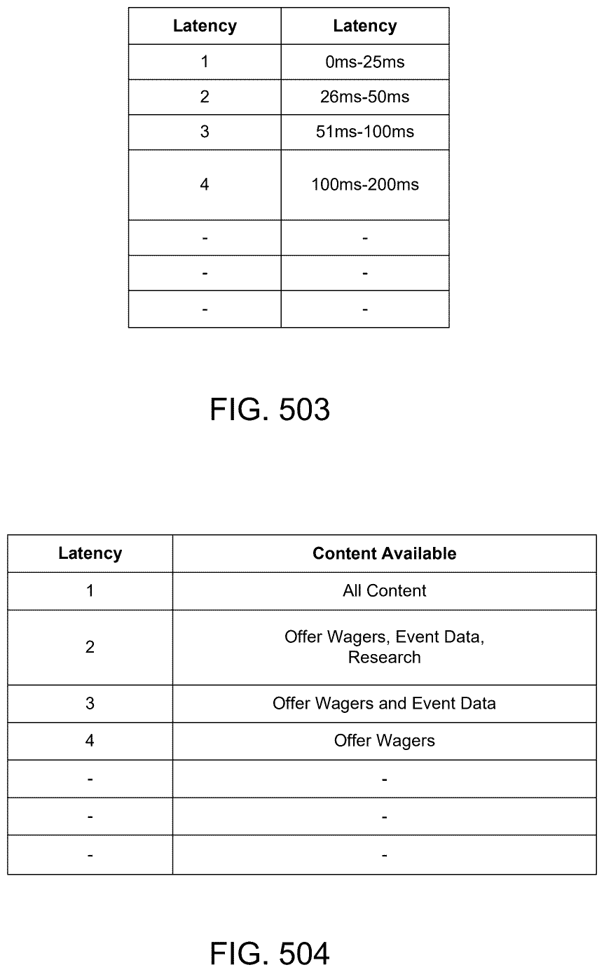

FIG. 504 illustrates a content database, according to an embodiment.

FIG. 499 is a system for optimizing wagering on a wagering platform. This system may include a live event 49902, for example, a sporting event such as a football, basketball, baseball, or hockey game, tennis match, golf tournament, eSports, or digital game, etc. The live event 49902 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 49902, such as the score of an American football game or the run line in a baseball game, or a series of actions in the live event 49902. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 49902 or at another location.

Further, embodiments may include a plurality of sensors 49904 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 49904 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 49906 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 49906 may be communicatively coupled to a peer-to-peer wagering network 49914, which may perform real-time analysis on the type of play and the result of the play. The cloud 49906 may also be synchronized with game situational data such as the time of the game, the score, location on the field, weather conditions, and the like, which may affect the choice of play utilized. For example, in an exemplary embodiment, the cloud 49906 may not receive data gathered from the sensors 49904 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 49908 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 49908 could be an optional component and would be utilized in a situation where a paired wearable device employs the mobile device 49908 for additional memory or computing power or connection to the internet.

Further, embodiments may include a wagering software application or a wagering app 49910, which is a program that enables the user to place bets on individual plays in the live event 49902, streams audio and video from the live event 49902, and features the available wagers from the live event 49902 on the mobile device 49908. The wagering app 49910 allows the user to interact with the wagering network 49914 to place bets and provide payment/receive funds based on wager outcomes.

Further, embodiments may include a mobile device database 49912 that may store some or all the user's data, the live event 49902, or the user's interaction with the wagering network 49914.

Further, embodiments may include the wagering network 49914, which may perform real-time analysis on the type of play and the result of a play or action. The wagering network 49914 (or the cloud 49906) may also be synchronized with game situational data, such as the time of the game, the score, location on the field, weather conditions, and the like, which may affect the choice of play utilized. For example, in an exemplary embodiment, the wagering network 49914 may not receive data gathered from the sensors 49904 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 49914 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 49916, which may contain data relevant to all users of the wagering network 49914 and may include, but is not limited to, a user ID, a device identifier, a paired device identifier, wagering history, or wallet information for the user. The user database 49916 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 49916 may contain betting lines and search queries. The user database 49916 may be searched based on a search criterion received from the user. Each betting line may include but is not limited to, a plurality of betting attributes such as at least one of the following: the live event 49902, a team, a player, an amount of wager, etc. The user database 49916 may include, but is not limited to, information related to all the users involved in the live event 49902. In one exemplary embodiment, the user database 49916 may include information for generating a user authenticity report and a wagering verification report. Further, the user database 49916 may be used to store user statistics like, but not limited to, the retention period for a particular user, frequency of wagers placed by a particular user, the average amount of wager placed by each user, etc.

Further, embodiments may include a historical plays database 49918 that may contain play data for the type of sport being played in the live event 49902. For example, in American Football, for optimal odds calculation, the historical play data may include metadata about the historical plays, such as time, location, weather, previous plays, opponent, physiological data, etc.

Further, embodiments may utilize an odds database 49920 that may contain the odds calculated by an odds calculation module 49922 to display the odds on the user's mobile device 49908 and take bets from the user through the mobile device wagering app 49910.

Further, embodiments may include the odds calculation module 49922, which may utilize historical play data to calculate odds for in-play wagers.

Further, embodiments may include a base module 49924, which may initiate the latency module 49926. For example, the latency module 49926 may connect to the mobile device 49908 and measure the latency of the connection between the wagering network 49914 and the mobile device 49908. For example, the latency may be measured using a ping service that can be used to measure round-trip latency. Ping may use the Internet Control Message Protocol (ICMP) echo request, which may cause the recipient to send the received packet as an immediate response; thus, it may provide a rough way of measuring round-trip delay time. Then latency module 49926 may compare the mobile device 49908 latency to the latency database 49930 and extract the latency level from the latency database 49930. The latency module 49926 may send the latency level to the content module 49928 and return to the base module 49924. Then the base module 49924 may initiate the content module 49928. For example, the content module 49928 may continuously poll for the latency level from the latency module 49926. Then the content module 49928 may receive the latency level from the latency module 49926 and may compare the latency level to the content database 49932. Then the content module 49928 may extract the listed content available associated with the latency level stored in the content database 49932. The content module 49928 may offer the listed content as available on the wagering app 49910. Then the content module 49928 may return to the base module 49924.

Further, embodiments may include a latency module 49926, beginning with the latency module 49926 being initiated by the base module 49924. The latency module 49926 may connect to the mobile device 49908. For example, the latency module 49926 may connect to the mobile device 49908 through a cloud or internet connection. The latency module 49926 may measure the latency of the mobile device 49908. For example, the latency may be measured using a ping service that can be used to measure round-trip latency. Ping may use the Internet Control Message Protocol (ICMP) echo request, which may cause the recipient to send the received packet as an immediate response; thus, it may provide a rough way of measuring round-trip delay time. Next, the latency module 49926 may compare the mobile device 49908 latency to the latency database 49930. For example, the latency module 49926 may use the estimate from the ping and may compare the estimated time to the latency database 49930 to determine the associated latency level. Then the latency module 49926 may extract the latency level from the latency database 49930. For example, if the mobile device has little latency, such as under 25 milliseconds, then the associated latency level may be 1, and as latency becomes worse, the associated level may increase, such as level 2 for latency between 26 milliseconds and 50 milliseconds, level 3 for latency between 51 milliseconds and 100 milliseconds, etc. Finally, the latency module 49926 may send the latency level to the content module 49928. For example, the latency module 49926 may send the latency level of 1 to the content module 49928 to determine which content features may be available on the wagering app 49910 located on the mobile device. Then the latency module 49926 may return to the base module 49924.

Further, embodiments may include a content module 49928, which may continuously poll for the latency level from the latency module 49926. For example, if the mobile device has little latency, such as under 25 milliseconds, then the associated latency level may be 1, and as the latency becomes worse, the associated level may increase, such as level 2 for latency between 26 milliseconds and 50 milliseconds, level 3 for latency between 51 milliseconds and 100 milliseconds, etc. Then the content module 49928 may receive the latency level from the latency module 49926. For example, the content module 49928 may receive the latency level of 1, 2, 3, 4, etc. The content module 49928 may compare the latency level to the content database 49932. For example, the content module 49928 may compare the latency level of 1 to the content database 49932, which the associated content may be to make all content features available on the wagering app 49910. Another example may be if the latency level is 4, such as very poor latency, then the available content features of the wagering app 49910 may be only to offer the wager odds. Then the content module 49928 may extract the listed content available associated with the latency level stored in the content database 49932. For example, the extracted content may be a list of available content offered by the wagering network associated latency level with the content; the lower the latency level, the less content the mobile device 49908 may receive. For example, if the mobile device has a latency of 150 milliseconds, the mobile device 49908 may have a latency level of 4, and the resulting content that may be offered on the wagering app 49910 may only be wager odds. In some embodiments, the content offered by the wagering network 49914 may be wager odds, event data, such as the players involved, score, time, etc., research articles or materials, audio of the live event 49902, a video feed of the live event 49902, etc. The content module 49928 may offer the listed content as available on the wagering app 49910. For example, the content module 49928 may allow a user on the mobile device 49908 to only select wager odds on the wagering app 49910 and not allow the user to select other content features of the wagering app 49910 if the mobile device 49908 has a latency level of 4 and thus has poor latency. In some embodiments, the content offered by the wagering network 49914 may be wager odds, event data, such as the players involved, score, time, etc., research articles or materials, audio of the live event 49902, a video feed of the live event 49902, etc. Then the content module 49928 may return to the base module 49924.

Further, embodiments may include a latency database 49930. The latency database 49930 may contain the latency speed ranges for the ping test performed in the latency module 49926 and the associated latency level. For example, if the mobile device 49908 has a latency of 24 milliseconds, the mobile device may be level 1 since it may be in the range of 0 milliseconds to 25 milliseconds. The latency level from the latency database 49930 may be extracted and used in the process described in the content module 49928. In some embodiments, the latency database 49930 may contain other internet factors to test the mobile device 49908, such as bandwidth, such as download and upload speed, Wi-Fi strength, cellular signal strength, etc.

Further, embodiments may include a content database 49932. The content database 49932 may contain a list of available content offered by the wagering network and an associated latency level with the content; the lower the latency level, the less content the mobile device 49908 may receive. For example, if the mobile device has a latency of 150 milliseconds, the mobile device 49908 may have a latency level of 4, which is described in the process of the latency module 49926, and the resulting content that may be offered on the wagering app 49910 may only be wagers. In some embodiments, the content offered by the wagering network 49914 may be wager odds, event data, such as the players involved, score, time, etc., research articles or materials, audio of the live event 49902, a video feed of the live event 49902, etc.

FIG. 500 illustrates the base module 49924. The process may begin with the base module 49924 initiating, at step 50000, the latency module 49926. For example, the latency module 49926 may connect to the mobile device 49908 and measure the latency of the mobile device 49908. For example, the latency may be measured using a ping service that can be used to measure round-trip latency. Ping may use the Internet Control Message Protocol (ICMP) echo request, which may cause the recipient to send the received packet as an immediate response; thus, it may provide a rough way of measuring round-trip delay time. Then latency module 49926 may compare the mobile device 49908 latency to the latency database 49930 and may extract the latency level from the latency database 49930. The latency module 49926 may send the latency level to the content module 49928 and may return to the base module 49924. Then the base module 49924 may initiate, at step 50002, the content module 49928. For example, the content module 49928 may continuously poll for the latency level from the latency module 49926. Then the content module 49928 may receive the latency level from the latency module 49926 and may compare the latency level to the content database 49932. Then the content module 49928 may extract the listed content available associated with the latency level stored in the content database 49932. The content module 49928 may offer the listed content as available on the wagering app 49910. Then the content module 49928 may return to the base module 49924.

FIG. 501 illustrates the latency module 49926. The process may begin with the latency module 49926 being initiated, at step 50100, by the base module 49924. The latency module 49926 may connect, at step 50102, to the mobile device 49908. For example, the latency module 49926 may connect to the mobile device 49908 through a cloud or internet connection. The latency module 49926 may measure, at step 50104, the latency of the mobile device 49908. For example, the latency may be measured using a ping service that can be used to measure round-trip latency. Ping may use the Internet Control Message Protocol (ICMP) echo request, which may cause the recipient to send the received packet as an immediate response; thus, it may provide a rough way of measuring round-trip delay time. The latency module 49926 may compare, at step 50106, the mobile device 49908 latency to the latency database 49930. For example, the latency module 49926 may use the estimate from the ping and may compare the estimated time to the latency database 49930 to determine the associated latency level. Then the latency module 49926 may extract, at step 50108, the latency level from the latency database 49930. For example, if the mobile device has little latency, such as under 25 milliseconds, then the associated latency level may be 1, and as latency becomes worse, the associated level may increase, such as level 2 for latency between 26 milliseconds and 50 milliseconds, level 3 for latency between 51 milliseconds and 100 milliseconds, etc. Next, the latency module 49926 may send, at step 50110, the latency level to the content module 49928. For example, the latency module 49926 may send the latency level of 1 to the content module 49928 to determine which content features may be available on the wagering app 49910 located on the mobile device. Then the latency module 49926 may return, at step 50112, to the base module 49924.

FIG. 502 illustrates the content module 49928. The process may begin with the content module 49928 being initiated, at step 50200, by the base module 49924. The content module 49928 may continuously poll, at step 50202, for the latency level from the latency module 49926. For example, if the mobile device has little latency, such as under 25 milliseconds, then the associated latency level may be 1, and as latency becomes worse, the associated level may increase, such as level 2 for latency between 26 milliseconds and 50 milliseconds, level 3 for latency between 51 milliseconds and 100 milliseconds, etc. Then the content module 49928 may receive, at step 50204, the latency level from the latency module 49926. For example, the content module 49928 may receive the latency level of 1, 2, 3, 4, etc. The content module 49928 may compare, at step 50206, the latency level to the content database 49932. For example, the content module 49928 may compare the latency level of 1 to the content database 49932, which the associated content may be to make all content features available on the wagering app 49910. Another example may be if the latency level is 4, such as very poor latency, then the available content features of the wagering app 49910 may be only to offer the wager odds. Then the content module 49928 may extract, at step 50208, the listed content available associated with the latency level stored in the content database 49932. For example, the extracted content may be a list of available content offered by the wagering network associated latency level with the content; the lower the latency level, the less content the mobile device 49908 may receive. For example, if the mobile device has a latency of 150 milliseconds, the mobile device 49908 may have a latency level of 4, and the resulting content that may be offered on the wagering app 49910 may only be wager odds. In some embodiments, the content offered by the wagering network 49914 may be wager odds, event data, such as the players involved, score, time, etc., research articles or materials, audio of the live event 49902, a video feed of the live event 49902, etc. The content module 49928 may offer, at step 50210, the listed content as available on the wagering app 49910. For example, the content module 49928 may allow a user on the mobile device 49908 to only select wager odds on the wagering app 49910 and not allow the user to select other content features of the wagering app 49910 if the mobile device 49908 has a latency level of 4. In some embodiments, the content offered by the wagering network 49914 may be wager odds, event data, such as the players involved, score, time, etc., research articles or materials, audio of the live event 49902, a video feed of the live event 49902, etc. Then the content module 49928 may return, at step 50212, to the base module 49924.

FIG. 503 illustrates the latency database 49930. The latency database 49930 may contain the latency speed ranges for the ping test performed in the latency module 49926 and the associated latency level. For example, if the mobile device 49908 has a latency of 24 milliseconds, the mobile device may be level 1 since it may be in the range of 0 milliseconds to 25 milliseconds. The latency level from the latency database 49930 may be extracted and used in the process described in the content module 49928. In some embodiments, the latency database 49930 may contain other internet factors to test the mobile device 49908, such as bandwidth, such as download and upload speed, Wi-Fi strength, cellular signal strength, etc.

FIG. 504 illustrates the content database 49932. The content database 49932 may contain a list of available content offered by the wagering network and an associated latency level with the content; the lower the latency level, the less content the mobile device 49908 may receive. For example, if the mobile device has a latency of 150 milliseconds, the mobile device 49908 may have a latency level of 4, which is described in the process of the latency module 49926, and the resulting content that may be offered on the wagering app 49910 may only be wagers. In some embodiments, the content offered by the wagering network 49914 may be wager odds, event data, such as the players involved, score, time, etc., research articles or materials, audio of the live event 49902, a video feed of the live event 49902, etc.

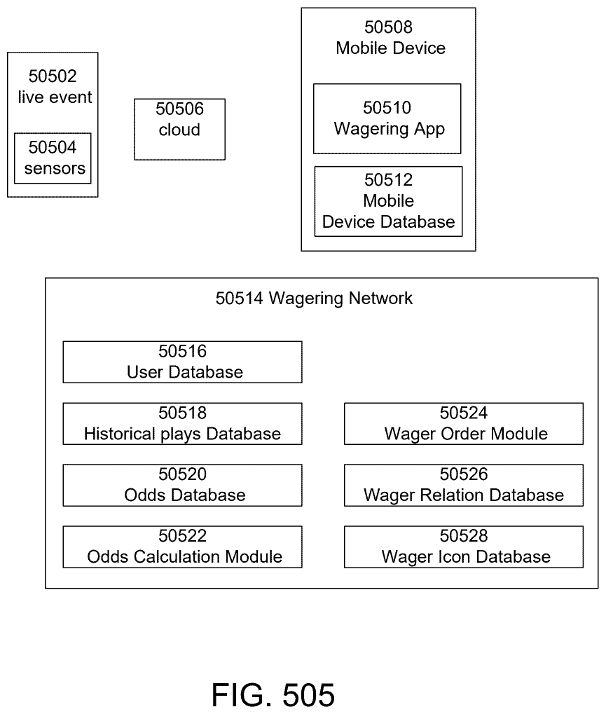

FIG. 505 illustrates a system for icon-based wager presentation, according to an embodiment.

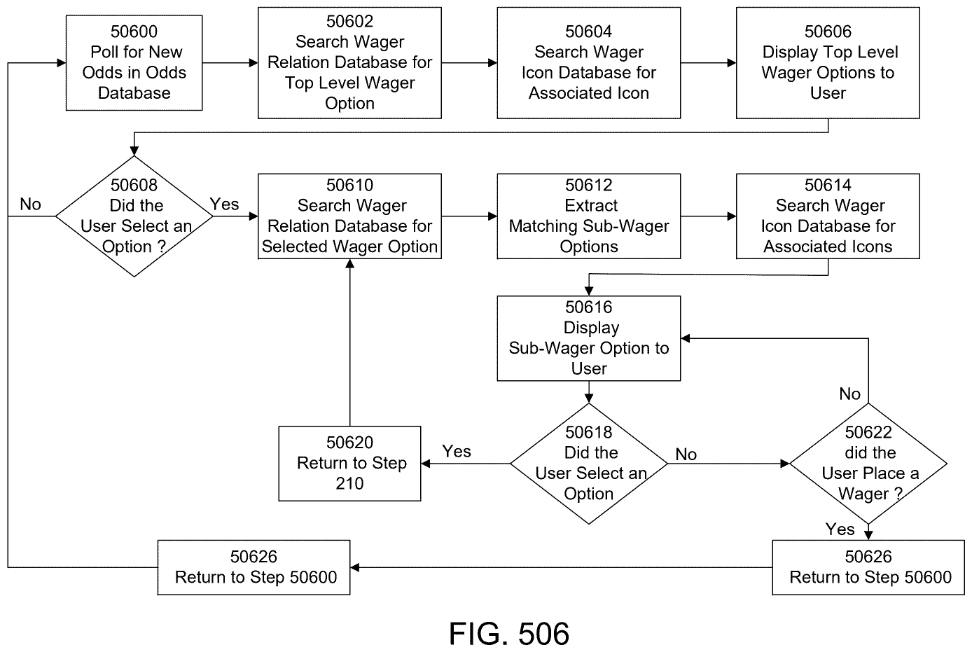

FIG. 506 illustrates a wager order module, according to an embodiment.

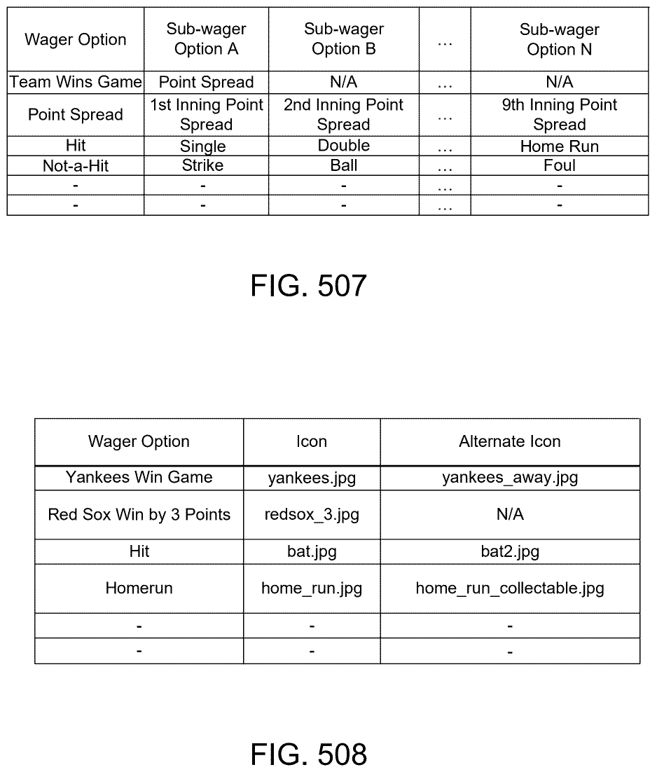

FIG. 507 illustrates a wager relation database, according to an embodiment.

FIG. 508 illustrates a wager icon database, according to an embodiment.

FIG. 505 is a system for icon-based wager presentation. This system may include a live event 50502, for example, a sporting event such as a football, basketball, baseball, or hockey game, tennis match, golf tournament, eSports, or digital game, etc. The live event 50502 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 50502, such as the score of an American football game or the run line in a baseball game, or a series of actions in the live event 50502. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 50502 or at another location.

Further, embodiments may include a plurality of sensors 50504 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 50504 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 50506 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 50506 may be communicatively coupled to a wagering network 50514, which may perform real-time analysis on the type of play and the result of the play. The cloud 50506 may also be synchronized with game situational data such as the time of the game, the score, location on the field, weather conditions, and the like, which may affect the choice of play utilized. For example, in an exemplary embodiment, the cloud 50506 may not receive data gathered from the sensors 50504 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 50508 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 50508 could be an optional component and may be utilized in a situation where a paired wearable device employs the mobile device 50508 for additional memory or computing power or connection to the internet.

Further, embodiments may include a wagering software application or a wagering app 50510, which is a program that enables the user to place bets on individual plays in the live event 50502, streams audio and video from the live event 50502, and features the available wagers from the live event 50502 on the mobile device 50508. The wagering app 50510 allows the user to interact with the wagering network 50514 to place bets and provide payment/receive funds based on wager outcomes.

Further, embodiments may include a mobile device database 50512 that may store some or all the user's data, the live event 50502, or the user's interaction with the wagering network 50514.

Further, embodiments may include the wagering network 50514, which may perform real-time analysis on the type of play and the result of a play or action. The wagering network 50514 (or the cloud 50506) may also be synchronized with game situational data, such as the time of the game, the score, location on the field, weather conditions, and the like, which may affect the choice of play utilized. For example, in an exemplary embodiment, the wagering network 50514 may not receive data gathered from the sensors 50504 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 50514 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 50516, which may contain data relevant to all users of the wagering network 50514 and may include, but is not limited to, a user ID, a device identifier, a paired device identifier, wagering history, or wallet information for the user. The user database 50516 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 50516 may contain betting lines and search queries. The user database 50516 may be searched based on a search criterion received from the user. Each betting line may include but is not limited to, a plurality of betting attributes such as at least one of the following: the live event 50502, a team, a player, an amount of wager, etc. The user database 50516 may include, but is not limited to, information related to all the users involved in the live event 50502. In one exemplary embodiment, the user database 50516 may include information for generating a user authenticity report and a wagering verification report. Further, the user database 50516 may be used to store user statistics like, but not limited to, the retention period for a particular user, frequency of wagers placed by a particular user, the average amount of wager placed by each user, etc.

Further, embodiments may include a historical plays database 50518 that may contain play data for the type of sport being played in the live event 50502. For example, in American Football, for optimal odds calculation, the historical play data may include metadata about the historical plays, such as time, location, weather, previous plays, opponent, physiological data, etc.

Further, embodiments may utilize an odds database 50520—that may contain the odds calculated by an odds calculation module 50522—to display the odds on the user's mobile device 50508 and take bets from the user through the mobile device wagering app 50510.

Further, embodiments may include the odds calculation module 50522, which may utilize historical play data to calculate odds for in-play wagers.

Further, embodiments may include a wager order module 50524, which may determine the order in which wager options may be shown to a user. This determination may include factors like the user's preferences, profit optimization, and which wager options are sub-options of other wager options.

Further, embodiments may include a wager relation database 50526, which may contain the relationship between wager options of different specificities. For example, in a baseball game, the result of a pitch could be a hit or not-a-hit, and each of these outcomes could be a wager option. However, the user could wager on a more specific wager option. For example, the hit is a home run or that the not-a-hit was a ball. These more specific wagers may be considered sub-wagers of the more general wagers and therefore may be associated.

Further, embodiments may include a wager icon database 50528, which may contain icons associated with wager options. For example, if a user wants to wager that a team will win the game, they may click on an icon with that team's logo or a symbol that represents that team.

FIG. 506 illustrates the wager order module 50524. The process may begin with the wager order module 50524 polling, at step 50600, for new odds in the odds database 50520. This polling may be new odds for one wager option or multiple wager options. These new odds may be generated due to the changing state of the live event 50502. The wager order module 50524 may search, at step 50602, the wager relation database 50526 for top-level wager options. Top-level wager options may be the wager options that are not sub-wager options of any other wager options. For example, a wager on a team to win might be a top-level option, whereas wagering on the number of points that a team will win is not a top-level wager option because the team would first have to win some number of points. The wager order module 50524 may search, at step 50604, the wager icon database 50528 for icons associated with the top-level wager options. There may be a number of alternative icons that could be selected for each wager option. For example, the wager option hit could be associated with an icon that is simply a baseball bat, but could also be associated with icons for each batter in the league. In an embodiment, the wager order module 50524 may select an icon based on the state of the live event 50502. For example, the wager order module 50524 may select the icon that depicts the current batter. In another embodiment, the wager order module 50524 may select an icon based on features of the mobile device 50508 such as operating system, screen size, accessibility options, type of display, etc. The wager order module 50524 may select an icon based on the history or preferences of the user such as favorite team, favorite player, previous bets, experience level, etc. The wager order module 50524 may display, at step 50606, the top-level wager options to the user via the wagering app 50510. This display may include the icon associated with the wager options. For example, if the top level wagering options are “bet who will win the game”, “bet who will be ahead this inning” “bet on the next play” and “bet on a player's performance”, then the user may see icons that depict a trophy, a scoreboard with innings, a baseball field, and a silhouette of a player, respectively. These icons may be accompanied by text that further describes the bet or category of bets. The wager order module 50524 may determine, at step 50608, if the user selected a wager option. The user may select the wager option by clicking or touching the icon associated with the wager option or other interactable elements such as text. If the user does not select a wager option, the wager order module 50524 may maintain the display until the user selects an option or until sometime has elapsed, in which case the wager order module 50524 may return to step 50600. If the user selected a wager option, the wager order module 50524 might search, at step 50610, the wager relation database 50526 for the selected wager option. The wager order module 50524 may extract, at step 50612, the sub-wager options associated with the matching wager option. The wager order module 50524 may search, at step 50614, the wager icon database 50528 for icons associated with the extracted sub-wager options. The wager order module 50524 may display, at step 50616, the extracted sub-wager options to the user via the wagering app 50510. This display may include the icon associated with the wager options. The wager order module 50524 may determine, at step 50618, if the user selected a wager option. The user may select the wager option by clicking or touching the icon associated with the wager option or other interactable elements such as text. If the user selected a sub-wager option, the wager order module 50524 might return, at step 50620, to step 50610 using the selected sub-wager option to search the wager relation database 50526. If the user did not select a sub-wager option, the wager order module 50524 might determine, at step 50622, if the user placed a wager. This selection may be a wager placed on the already selected wager option. For example, if a user selects “hit” as their original wager option, the user may be shown the sub-wager options for “hit,” which may include “single,” “double,” or “home run.” But the user may still be able to place a wager that the next play will be a hit without further selecting what type of hit it may be. If the user does not place a wager or select a sub-wager option, the wager order module 50524 may maintain the display until the user selects an option or until sometime has elapsed, in which case the wager order module 50524 may return to step 50600. If the user placed a wager, the wager order module 50524 might store, at step 50624, the wager data in the user database 50516. The wager order module 50524 may return, at step 50626, to step 50600.

FIG. 507 illustrates the wager relation database 50526. The wager relation database 50526 may include several wager options associated based on the relationship between those options. For example, a “single” in baseball may be a sub-wager of a wager for a “hit” since all singles are hits, but not all hits are singles. These relationships may be based on the rules of the game. An algorithm may learn these relationships based on statistical user wager behavior.

FIG. 508 illustrates the wager icon database 50528. The wager icon database 50528 may contain one or more icons that are associated with a wager option. Icons may be picture, video, or multi-media files such as .jpg files, .gif files, .png files, .mov files, etc. The database may contain links to databases or websites where the icon may be retrieved from. For example, if a set of icons depict baseball players, then their portraits may be retrieved from a database of current player portraits. When the user would be displayed a wager option, the icon may be displayed alongside the text of the wager option in place of the wager option. For example, if one of the wager options available is that the next play will be a hit, the user may see the word “hit” under a picture of a baseball bat. In addition, alternate icons may be displayed if certain circumstances occur, such as the original icon is unavailable, the team is home or away, a holiday or special event is occurring, some percentage of users are randomly assigned an alternate icon, etc. For example, an icon that depicts a baseball field may use the colors of the team that is at home on that field. For another example, icons may have their colors changed to predominately be red, white, and blue on the fourth of July. Finally, icons may be collectible such that once a user has earned the icon, it may be displayed to that user. For example, users who placed a bet on the fourth of July may be able to use the red, white, and blue version of an icon year round instead of the default icon.

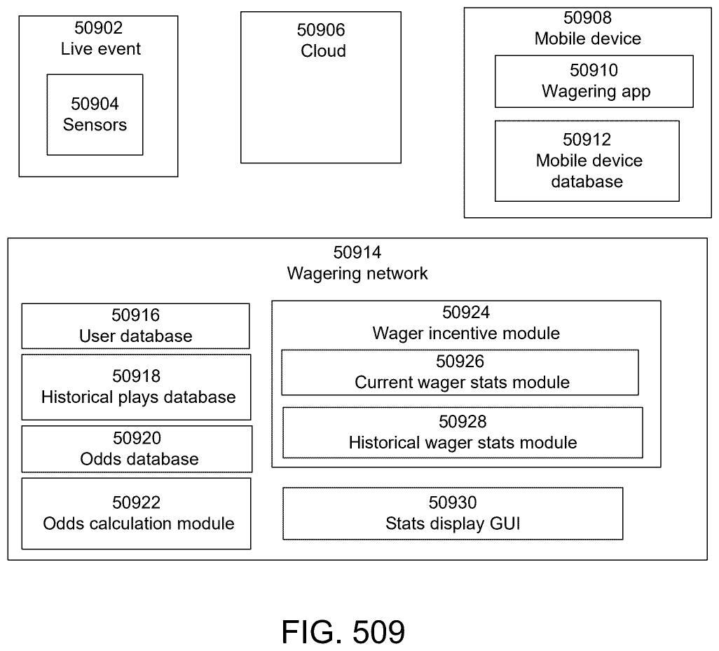

FIG. 509 illustrates a system for using wagering statistics to incentivize wagering, according to an embodiment.

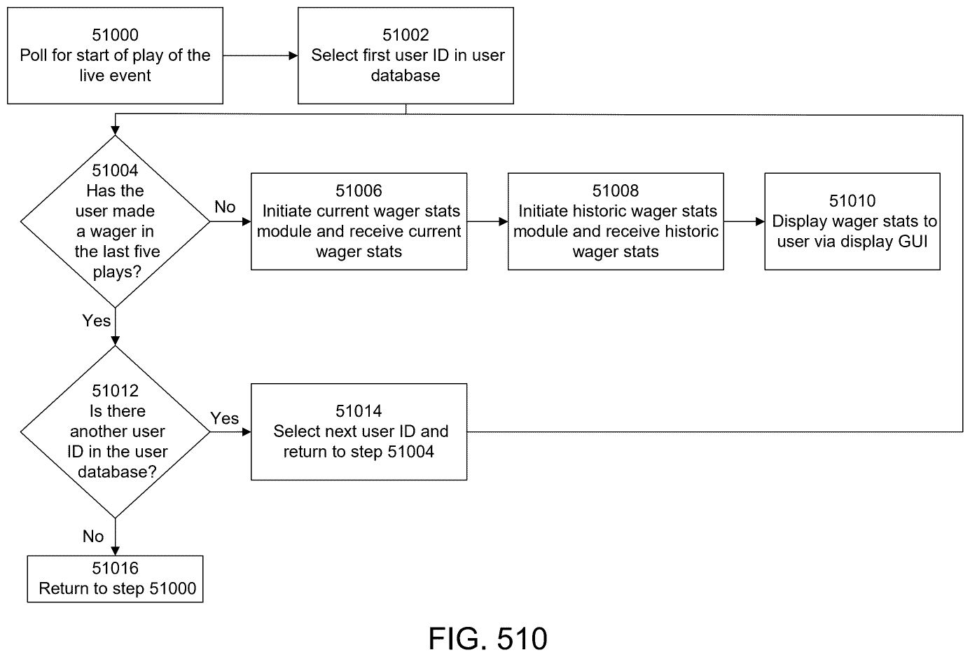

FIG. 510 illustrates a wager incentive module, according to an embodiment.

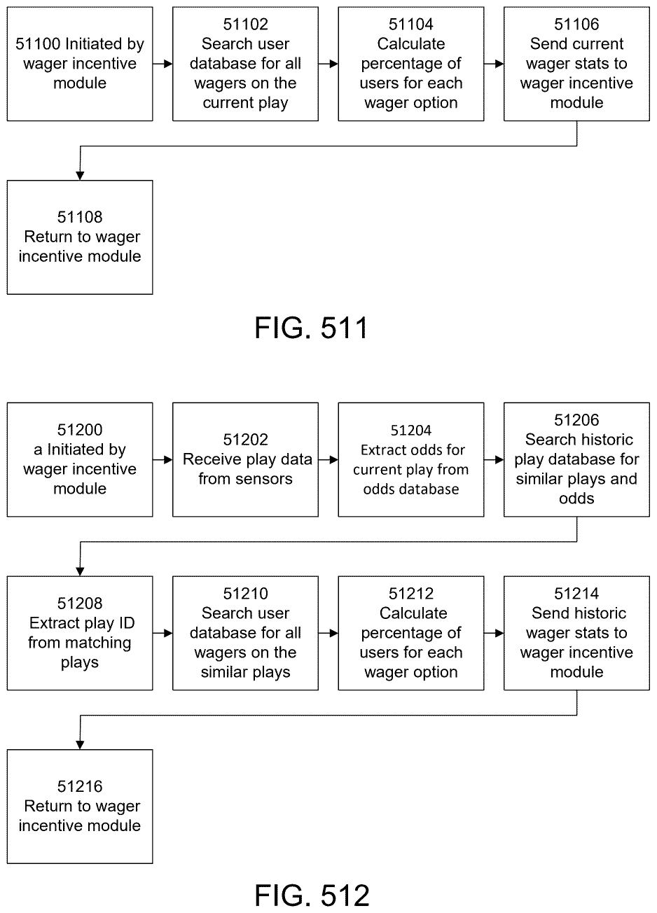

FIG. 511 illustrates a current wager stats module, according to an embodiment.

FIG. 512 illustrates a historical wager stats module, according to an embodiment.

FIG. 509 is a system for using wagering statistics to incentivize wagering. This system may include a live event 50902, for example, a sporting event such as a football, basketball, baseball, or hockey game, tennis match, golf tournament, eSports, or digital game, etc. The live event 50902 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 50902, such as the score of an American football game or the run line in a baseball game, or a series of actions in the live event 50902. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 50902 or at another location.

Further, embodiments may include a plurality of sensors 50904 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 50904 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 50906 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 50906 may be communicatively coupled to a peer-to-peer wagering network 50914, which may perform real-time analysis on the type of play and the result of the play. The cloud 50906 may also be synchronized with game situational data such as the time of the game, the score, location on the field, weather conditions, and the like, which may affect the choice of play utilized. For example, in an exemplary embodiment, the cloud 50906 may not receive data gathered from the sensors 50904 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 50908 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 50908 could be an optional component and would be utilized in a situation where a paired wearable device employs the mobile device 50908 for additional memory or computing power or connection to the internet.

Further, embodiments may include a wagering software application or a wagering app 50910, which is a program that enables the user to place bets on individual plays in the live event 50902, streams audio and video from the live event 50902, and features the available wagers from the live event 50902 on the mobile device 50908. The wagering app 50910 allows the user to interact with the wagering network 50914 to place bets and provide payment/receive funds based on wager outcomes.

Further, embodiments may include a mobile device database 50912 that may store some or all the user's data, the live event 50902, or the user's interaction with the wagering network 50914.

Further, embodiments may include the wagering network 50914, which may perform real-time analysis on the type of play and the result of a play or action. The wagering network 50914 (or the cloud 50906) may also be synchronized with game situational data, such as the time of the game, the score, location on the field, weather conditions, and the like, which may affect the choice of play utilized. For example, in an exemplary embodiment, the wagering network 50914 may not receive data gathered from the sensors 50904 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 50914 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 50916, which may contain data relevant to all users of the wagering network 50914 and may include, but is not limited to, a user ID, a device identifier, a paired device identifier, wagering history, or wallet information for the user. The user database 50916 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 50916 may contain betting lines and search queries. The user database 50916 may be searched based on a search criterion received from the user. Each betting line may include but is not limited to, a plurality of betting attributes such as at least one of the following: the live event 50902, a team, a player, an amount of wager, etc. The user database 50916 may include, but is not limited to, information related to all the users involved in the live event 50902. In one exemplary embodiment, the user database 50916 may include information for generating a user authenticity report and a wagering verification report. Further, the user database 50916 may be used to store user statistics like, but not limited to, the retention period for a particular user, frequency of wagers placed by a particular user, the average amount of wager placed by each user, etc.

Further, embodiments may include a historical plays database 50918 that may contain play data for the type of sport being played in the live event 50902. For example, in American Football, for optimal odds calculation, the historical play data may include metadata about the historical plays, such as time, location, weather, previous plays, opponent, physiological data, etc.

Further, embodiments may utilize an odds database 50920—that contains the odds calculated by an odds calculation module 50922—to display the odds on the user's mobile device 50908 and take bets from the user through the mobile device wagering app 50910.

Further, embodiments may include the odds calculation module 50922, which may utilize historical play data to calculate odds for in-play wagers.

Further, embodiments may include a wager incentive module 50924, which may detect users that have not yet placed a wager on the current play and incentivize them to place a wager by showing wager stats. For example, targeting the user based on the prior wager history of the user. The purpose of this incentive may be to balance the books to minimize possible losses for the system or to increase user engagement and retention. Wager stats may be calculated by a current wager stats module 50926 or a historical wager stats module 50928 and displayed via the stats display GUI 50930.

Further, embodiments may include the current wager stats module 50926, which may calculate the percentage of users who have chosen a wager option for the current play of the live event 50902.

Further, embodiments may include the historical wager stats module 50928, which may calculate the percentage of users who chose a wager option for a historical play like the current play of the live event 50902.

Further, embodiments may include a stats display GUI 50930, which may display the user's current or historical wager stats. The stats display GUI 50930 may be part of the wagering app 50910 or mobile device 50908.

FIG. 510 illustrates the wager incentive module 50924. The process may begin with the wager incentive module 50924 polling, at step 51000, for the start of a play of the live event 50902. This data may be obtained from the sensors 50904 at the live event 50902. The wager incentive module 50924 may select, at step 51002, the first user ID in the user database 50916. The wager incentive module 50924 may determine, at step 51004, if the user has made a wager in the last five plays for which a wager was available. The number of plays since the user's last wager may be determined by searching the user database 50916 for instances of the user ID within the last five plays. The threshold number of plays may be different than five and may be static or dynamic. The threshold number may be different for each user. The threshold may be based on the average behavior of the user. For example, a user who usually makes one wager out of every five plays a game may have a threshold higher than five, such as ten. A user that usually wagers on every play may have a threshold of two or three plays. The threshold may be a metric other than the number of plays such as the amount wagered per minute, average amount wagered per play, time since the last wager, time since the last wager above a set dollar amount, or any other metric which may be useful in determining user engagement. The wager incentive module 50924 may ignore inactive user IDs. If the user has made a wager in the last five plays for which a wager was available, the wager incentive module 50924 may skip to step 51012. If the user has not made a wager in the last five plays for which a wager was available, the wager incentive module 50924 may initiate, at step 51006, the current wager stats module 50926 and may receive the current wager stats. The wager incentive module 50924 may initiate, at step 51008, the historical wager stats module 50928 and may receive the historical wager stats. The wager incentive module 50924 may display, at step 51010, the wager stats via the display GUI 50930. Wager stats may include stats on the current wager or historical wagers. Stats may refer to the percentage of users that placed a wager on a wager option. Not all wager options may be displayed by the display GUI 50930. For example, during a play in a baseball game, the user may only be shown the percentage of players that bet on a home run. and displaying the amount of action on either side of a wagering market may incentivize the user to place a wager for a home run if the option is popular. For example, targeting a user based on the prior wager history of the user. The user may be shown only the historic statistics and not the current statistics, or vice versa. The user may be shown the statistics for one wager option, multiple wager options, or all wager options. The user may be shown a matrix of statistics with some statistics excluded. For example, if there are five wager options A, B, C, D, and E, the user may be shown the historic statistics for wager options A and B, the current statistics for wager options A, C, and D, and no statistics for wager option E. The statistics shown to the user may be set by an administrator or by another module. Artificial intelligence or machine learning may be used to determine which combination of statistics would be most likely to incentivize wagering. The wager incentive module 50924 may determine, at step 51012, if there is another user ID in the user database 50916. If there is another user ID in the user database 50916, the wager incentive module 50924 may select, at step 51014, the next user ID and return to step 51004. If there are no more user IDs in the user database 50916, the wager incentive module 50924 may return, at step 51016, to step 51000.

FIG. 511 illustrates the current wager stats module 50926. The process may begin with the current wager stats module 50926 being initiated, at step 51100, by the wager incentive module 50924. The current wager stats module 50926 may search, at step 51102, the user database 50916 for all wagers on the current play of the live event 50902. The current wager stats module 50926 may calculate, at step 51104, the percentage of users for each wager option. For example, if 60 out of 100 users wagered that the result of the current play would be a pass and 40 out of 100 users wagered that the current play would be a run the percentage of users that wagered on a pass would be 60%, and the percentage of users that wagered on a run would be 40%. The current wager stats module 50926 may send, at step 51106, the current wager stats to the wager incentive module 50924. Stats may include the percentage of users for each wager option or the wager options themselves. The current wager stats module 50926 may return, at step 51108, to the wager incentive module 50924

FIG. 512 illustrates the historical wager stats module 50928. The process may begin with the historical wager stats module 50928 being initiated, at step 51200, by the wager incentive module 50924. The historical wager stats module 50928 may receive, at step 51202, play data from the sensors 50904. Play data may include metrics that may affect the outcome of the play and may include the players, teams, score, game state, weather, etc. The historical wager stats module 50928 may extract, at step 51204, odds for the current play from the odds database 50920. The historical wager stats module 50928 may search, at step 51206, the historical plays database 50918 for plays similar to the current play and have similar odds. Similar may not mean an exact match. For example, two plays with the same teams, players, and game state but with a difference in wind speed of 5 mph may be considered similar. Odds of 1:2 and 1:2:1 may also be considered similar. The plays and odds that may be considered similar may be determined by an administrator or another module. The historical wager stats module 50928 may extract, at step 51208, a play ID or other identifier from each matching play in the historical plays database 50918. The historical wager stats module 50928 may search, at step 51210, the user database 50916 for all wagers on similar plays. The historical wager stats module 50928 may calculate, at step 51212, the percentage of users that wagered on each wager option. For example, if 600 out of 1000 users wagered that the result of similar historical plays would be a pass and 400 out of 1000 users wagered that the result of similar historical plays would be a run, the percentage of users that wagered on a pass would be 60%, and the percentage of users that wagered on a run would be 40%. Each historical play may be evaluated separately or as a group. The historical wager stats module 50928 may send, at step 51214, the current wager stats to the wager incentive module 50924. Stats may include the percentage of users for each wager option, or the wager options themselves. Stats may include separate stats for each similar historic play. The historical wager stats module 50928 may return, at step 51216, to the wager incentive module 50924.

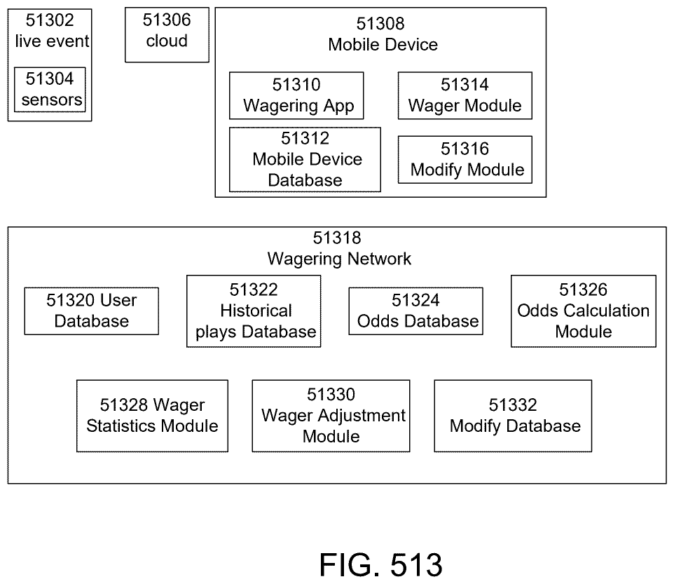

FIG. 513 illustrates a system for modifying a wager after wager statistics are displayed, according to an embodiment.

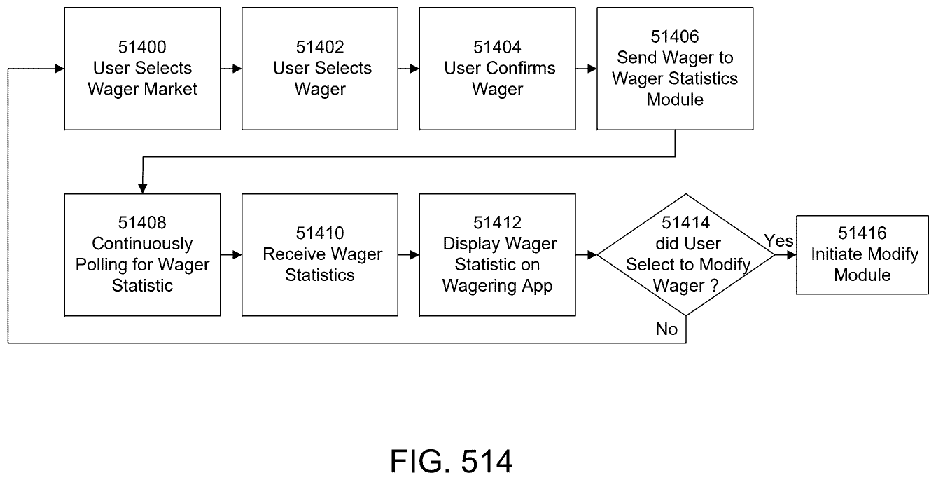

FIG. 514 illustrates a wager module, according to an embodiment.

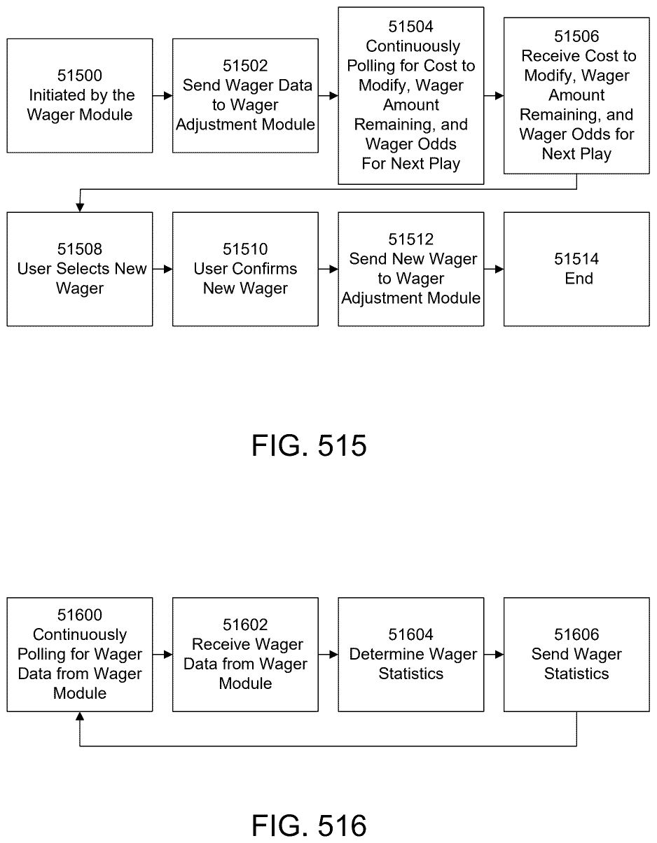

FIG. 515 illustrates a modify module according to an embodiment.

FIG. 516 illustrates a wager statistics module, according to an embodiment.

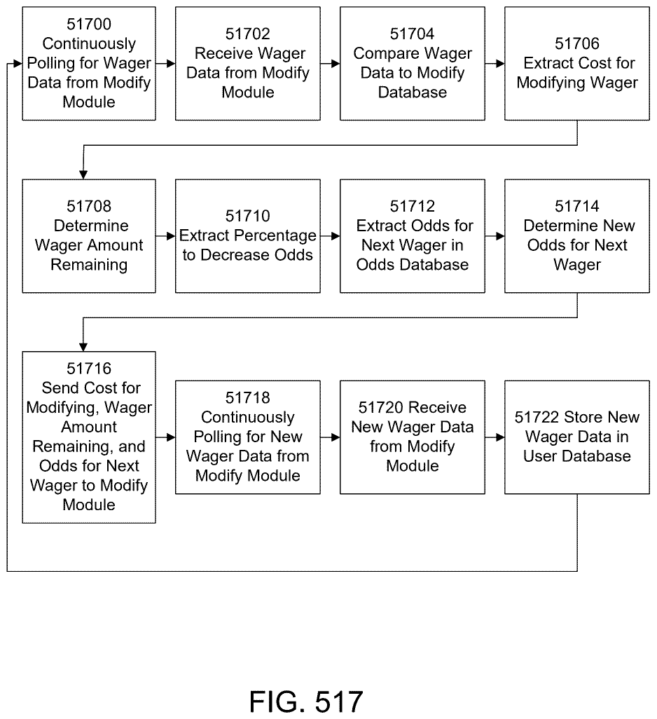

FIG. 517 illustrates a wager adjustment module, according to an embodiment.

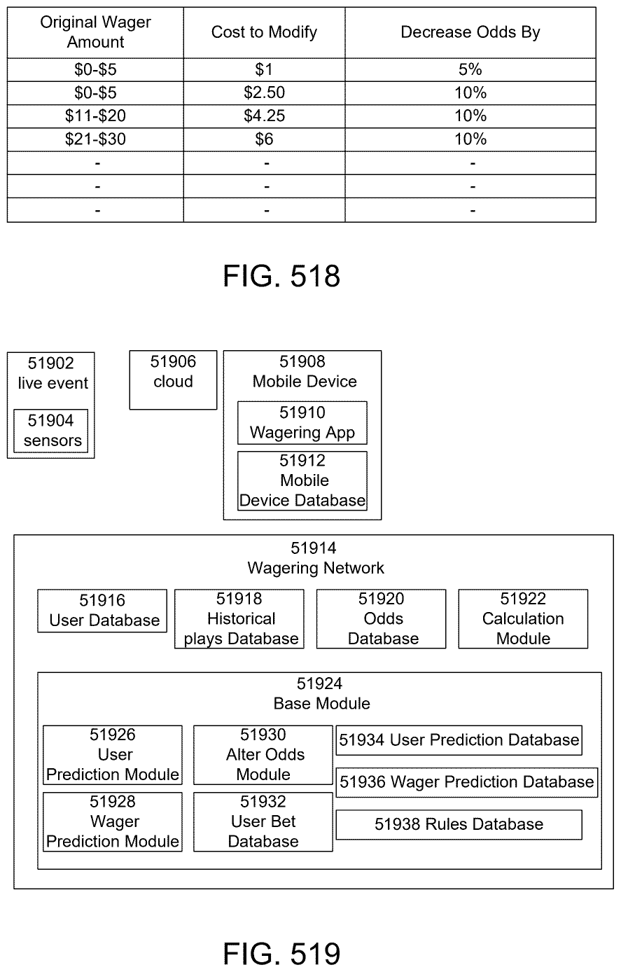

FIG. 518 illustrates a modify database, according to an embodiment.

FIG. 513 is a system for modifying a wager after wager statistics are displayed. This system may include a live event 51302, for example, a sporting event such as a football, basketball, baseball, or hockey game, tennis match, golf tournament, eSports or digital game, etc. The live event 51302 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 51302, such as the score of an American football game or the run line in a baseball game, or a series of actions in the live event 51302. Sportsbooks have several bets they can handle which limit the amount of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 51302 or at another location.

Further, embodiments may include a plurality of sensors 51304 that may be used such as motion, temperature, or humidity sensors, optical sensors and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 51304 may include, but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 51306 or a communication network that may be a wired and/or a wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 51306 may be communicatively coupled to a peer-to-peer wagering network 51318, which may perform real-time analysis on the type of play and the result of the play. The cloud 51306 may also be synchronized with game situational data such as the time of the game, the score, location on the field, weather conditions, and the like, which may affect the choice of play utilized. For example, in an exemplary embodiment, the cloud 51306 may not receive data gathered from the sensors 51304 and may, instead, receive data from an alternative data feed, such as Sports Radar®. This data may be compiled substantially immediately following the completion of any play, and may be compared with a variety of team data and league data based on a variety of elements, including the current down, possession, score, time, team, and so forth, as described in various exemplary embodiments herein.

Further, embodiments may include a mobile device 51308 such as a computing device, laptop, smartphone, tablet, computer, smart speaker, or I/O devices. I/O devices may be present in the computing device. Input devices may include, but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, infrared optical sensors, pressure sensors, magnetometer sensors, angular rate sensors, depth sensors, proximity sensors, ambient light sensors, gyroscopic sensors, or other sensors. Output devices may include, but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including, but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices including, but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 51308 could be an optional component and would be utilized in a situation where a paired wearable device employs the mobile device 51308 for additional memory or computing power or connection to the internet.

Further, embodiments may include a wagering software application or a wagering app 51310, which is a program that enables the user to place bets on individual plays in the live event 51302, streams audio and video from the live event 51302, and features the available wagers from the live event 51302 on the mobile device 51308. The wagering app 51310 allows the user to interact with the wagering network 51318 to place bets and provide payment/receive funds based on wager outcomes.

Further, embodiments may include a mobile device database 51312 that may store some or all the user's data, the live event 51302, or the user's interaction with the wagering network 51318.

Further, embodiments may include a wager module 51314, which may begin with the user selecting a wagering market. For example, the user selects the Boston Red Sox vs. the New York Yankees event during the J. D. Martinez at-bat in the first inning. Then the user selects a wager. For example, the user selects the wager that J. D. Martinez will hit a single in the first inning at-bat during the Boston Red Sox vs. the New York Yankees event. The user confirms the selected wager. For example, the user confirms the wager that J. D. Martinez will hit a single in the first inning at-bat during the Boston Red Sox vs. the New York Yankees event. Then the wager module 51314 sends the confirmed wager to a wager statistics module 51328. For example, the wager of J. D. Martinez will hit a single in the first inning at-bat during the Boston Red Sox vs. the New York Yankees event is sent to the wager statistics module 51328. Then the wager module 51314 continuously polls for the wager statistics from the wager statistics module 51328. For example, the wager module 51314 continuously polls for the statistics on the sent wager, such as the percent of the wagers on J. D. Martinez hitting a single, double, triple, or home run from other users of the wagering app 51310. The wager module 51314 receives the wager statistics from the wager statistics module 51328. For example, the wager module 51314 receives the sent wager statistics, such as the percent of the wagers on J. D. Martinez hitting a single, double, triple, home run, walk, strikeout, groundout, or fly out from other users of the wagering app 51310. Then the wager module 51314 displays the wager statistics on the wagering app 51310. For example, the percentage of the wagers on J. D. Martinez hitting a single, double, triple, or home run from other users of the wagering app 51310 are displayed. Then it is determined if the user selects to modify the wager. If it is determined that the user did not select to modify the wager, then the process returns to the user selecting a wagering market. If it is determined that the user selected to modify the wager, then the wager module 51314 initiates a modify module 51316. For example, the user may wish to modify the confirmed wager of J. D. Martinez will hit a single in the first inning at-bat during the Boston Red Sox vs. the New York Yankees event after seeing the wager statistics. An instance may be if that there is a runner on second and first base is open, there may be greater odds that the result of at-bat would result in a walk and that the majority of other users selected the walk wager and the user wants to modify the wager of the at-bat resulting in a single to take decreased odds on the next play in the event.

Further, embodiments may include the modify module 51316, which may begin with the modify module 51316 being initiated by the wager module 51314. Then the modify module 51316 sends the wager data to a wager adjustment module 51330. For example, the wager data may be the user ID, such as JS123456, the wagered amount, such as $20, and the wager, such as J. D. Martinez, will hit a single in the first inning at-bat during the Boston Red Sox vs. the New York Yankees event. Then the modify module 51316 continuously polls for the cost to modify the wager, the wager amount remaining, and the odds for the next play. For example, the modify module 51316 continuously polls for the cost to modify the wager, such as $4.50, the wager amount remaining, such as $15.50, and the decreased odds for the next play. For example, during the next at-bat, the odds would be decreased 15% for Xander Bogaerts to hit a single, double, triple, home run, walk, strikeout, ground out, or flyout. The modify module 51316 receives the cost to modify the wager, the wager amount remaining, and the odds for the next play. For example, the modify module 51316 receives the cost to modify the wager, such as $4.50, the wager amount remaining, such as $15.50, and the decreased odds for the next play. For example, during the next at-bat, the odds would be decreased 15% for Xander Bogaerts to hit a single, double, triple, home run, walk, strikeout, ground out, or flyout. Then the user selects the new wager. For example, the user selects that Xander Bogaerts will hit a single with the odds to decreased by 15% for $15.50 in the Boston Red Sox vs. the New York Yankees event.

For example, if the original odds for Xander Bogaerts to hit a single were 6:1, then the user would be offered the odds 5.1:1 since the odds would be decreased by 15%. The user confirms the new wager. For example, the user confirms the wager that Xander Bogaerts will hit a single with the odds to decreased by 15% for $15.50 in the Boston Red Sox vs. the New York Yankees event. For example, if the original odds for Xander Bogaerts to hit a single were 6:1, then the user would be offered the odds 5.1:1 since the odds would be decreased by 15%. Then the modify module 51316 sends the new wager to the wager adjustment module 51330. For example, the modify module 51316 sends the wager that Xander Bogaerts will hit a single with the odds of 5.1:1 for $15.50 in the Boston Red Sox vs. the New York Yankees event. Then the modify module 51316 ends.

Further, embodiments may include the wagering network 51318, which may perform real-time analysis on the type of play and the result of a play or action. The wagering network 51318 (or the cloud 51306) may also be synchronized with game situational data, such as the time of the game, the score, location on the field, weather conditions, and the like, which may affect the choice of play utilized. For example, in an exemplary embodiment, the wagering network 51318 may not receive data gathered from the sensors 51304 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 51318 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 51320, which may contain data relevant to all users of the wagering network 51318 and may include, but is not limited to, a user ID, a device identifier, a paired device identifier, wagering history, or wallet information for the user. The user database 51320 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 51320 may contain betting lines and search queries. The user database 51320 may be searched based on a search criterion received from the user. Each betting line may include, but is not limited to, a plurality of betting attributes such as at least one of the live event 51302, a team, a player, an amount of wager, etc. The user database 51320 may include but is not limited to information related to all the users involved in the live event 51302. In one exemplary embodiment, the user database 51320 may include information for generating a user authenticity report and a wagering verification report. Further, the user database 51320 may be used to store user statistics like, but not limited to, the retention period for a particular user, frequency of wagers placed by a particular user, the average amount of wager placed by each user, etc.

Further, embodiments may include a historical plays database 51322 that may contain play data for the type of sport being played in the live event 51302. For example, in American Football, for optimal odds calculation, the historical play data may include metadata about the historical plays, such as time, location, weather, previous plays, opponent, physiological data, etc.

Further, embodiments may utilize an odds database 51324 that contains the odds calculated by an odds calculation module 51326 to display the odds on the user's mobile device 51308 and take bets from the user through the mobile device wagering app 51310.

Further, embodiments may include the odds calculation module 51326, which utilizes historical play data to calculate odds for in-play wagers.

Further, embodiments may include the wager statistics module 51328, which may begin with the wager statistics module 51328 continuously polling for the wager data from the wager module 51314. For example, the wager statistics module 51328 continuously polls for the user's wager that J. D. Martinez will hit a single in the first inning at-bat during the Boston Red Sox vs. the New York Yankees event. Then the wager statistics module 51328 receives the wager data from the wager module 51314. For example, the wager statistics module 51328 receives the wager that J. D. Martinez will hit a single in the first inning at-bat during the Boston Red Sox vs. the New York Yankees event. The wage statistics module 51328 determines the wager statistics for the confirmed wager. For example, the wager statistics module 51328 may determine the number of users that placed a wager for J. D. Martinez to hit a single in the first inning in the Boston Red Sox vs. the New York Yankees event. The wager statistics module 51328 may determine this by filtering the odds database 51324 for all the wagers placed on the J. D. Martinez at-bat and counting one for each wager, then filter the wagers for the result to be J. D. Martinez hitting a single and count one for each wager, then divide the total amount of wagers resulting in a single by the total amount of wagers placed to determine the percentage of how many users wagered for J. D. Martinez to hit a single. In some embodiments, the statistics may be presented for all the possible outcomes of the at-bat, such as single, double, triple, home run, walk, strikeout ground out, or fly out and these may be calculated using the same method to determine the percentages of users that placed those wagers. In some embodiments, the statistics may involve how much money was wagered on each wager, the increase or decrease percentages of the odds since the wagers were offered, the amount of time the wagers have been offered, etc. Then the wager statistics module 51328 sends the wager statistics to the wager module 51314, and the process returns to continuously polling for the wager data from the wager module 51314. For example, the wager statistics module 51328 sends the wager statistics, such as the percent of the wagers on J. D. Martinez hitting a single, double, triple, home run, walk, strikeout, groundout, or fly out other users of the wagering app 51310.

Further, embodiments may include the wager adjustment module 51330, which may begin with the wager adjustment module 51330 continuously polling for the wager data from the modify module 51316. For example, the wager data may be the user ID, such as JS123456, the wagered amount, such as $20, and the wager, such as J. D. Martinez, will hit a single in the first inning at-bat during the Boston Red Sox vs. the New York Yankees event. Then the wager adjustment module 51330 receives the wager data from the modify module 51316. For example, the wager data may be the user ID, such as JS123456, the wagered amount, such as $20, and the wager, such as J. D. Martinez, will hit a single in the first inning at-bat during the Boston Red Sox vs. the New York Yankees event. The wager adjustment module 51330 compares the wager data to a modify database 51332. For example, the wager adjustment module 51330 compares the original wagered amount, such as $20, to the modify database 51332 to determine the corresponding cost to modify, such as $4.50, and the percentage to decrease the odds on the next play by, such as 15%. Then the wager adjustment module 51330 extracts the cost for modifying the wager. For example, the wager adjustment module 51330 extracts the corresponding cost to modify the wager. For example, if the user wagered $20, the cost to modify would be $4.50. Then the wager adjustment module 51330 determines the wager amount remaining. For example, the wager adjustment module 51330 subtracts the cost to modify, such as $4.50, from the original amount wagered, such as $20, resulting in a $15.50 amount remaining for the user to wager on the next play. The wager adjustment module 51330 extracts the percentage to decrease the odds from the modify database 51332. For example, the wager adjustment module 51330 extracts the corresponding percentage to decrease the odds for the next play. For example, if the user wagered $20, the odds would decrease by 15% on the next play. Then the wager adjustment module 51330 extracts the odds for the next wager in the odds database 51324. For example, the next play may the at-bat for Xander Bogaerts in the first inning in the Boston Red Sox vs. the New York Yankees, with the odds for Xander Bogaerts to hit a single being 6:1. In some embodiments, the odds may also include for Xander Bogaerts to hit a single, double, triple, home run, walk, strikeout, ground out, or flyout. The wager adjustment module 51330 determines the new odds for the next wager. For example, if the odds for Xander Bogaerts to hit a single were 6:1, they would be decreased by 15%, creating new odds for user ID JS12345 of 5.1:1. Then the wager adjustment module 51330 sends the cost for modifying the wager, the wager amount remaining, and the odds for the next wager to the modify module 51316. For example, the wager adjustment module 51330 the cost to modify the wager, such as $4.50, the wager amount remaining, such as $15.50, and the decreased odds for the next play. For example, during the next at-bat, the odds would be decreased 15% for Xander Bogaerts to hit a single, double, triple, home run, walk, strikeout, ground out, or flyout. The wager adjustment module 51330 is continuously polling for the new wager data from the modify module 51316. For example, the wager adjustment module 51330 is continuously polling for the new wager data, such as $15.50 on 5.1:1 for Xander Bogaerts to hit a single in the first inning of the Boston Red Sox vs. the New York Yankees event. Then the wager adjustment module 51330 receives the new wager data from the modify module 51316. For example, the wager adjustment module 51330 receives the new wager data, such as $15.50 on 5.1:1 for Xander Bogaerts to hit a single in the first inning of the Boston Red Sox vs. the New York Yankees event. The wager adjustment module 51330 stores the new wager data in the user database 51320, and the process returns to continuously polling for the wager data from the modify module 51316.

Further, embodiments may include the modify database 51332. The database may contain the original wager amount, the cost to modify the wager, and the percentage to decrease the odds by. In some embodiments, the cost to modify the wager may be a percentage of the original amount or a predetermined number. In some embodiments, the percentage to decrease the odds may be determined based on the original odds. For example, the higher the odds, the more they are decreased. In some embodiments, the database may contain a list of available wagers that the user can wager to prevent the user from selecting wagers with uncommonly high odds. Finally, in some embodiments, the database may contain a limit on the number of times a user can modify a wager.

FIG. 514 illustrates the wager module 51314. The process begins with the user selecting, at step 51400, a wagering market. For example, the user selects the Boston Red Sox vs. the New York Yankees event during the J. D. Martinez at-bat in the first inning. Then the user selects, at step 51402, a wager. For example, the user selects the wager that J. D. Martinez will hit a single in the first inning at-bat during the Boston Red Sox vs. the New York Yankees event. The user confirms, at step 51404, the selected wager. For example, the user confirms the wager that J. D. Martinez will hit a single in the first inning at-bat during the Boston Red Sox vs. the New York Yankees event. Then the wager module 51314 sends, at step 51406, the confirmed wager to the wager statistics module 51328. For example, the wager of J. D. Martinez will hit a single in the first inning at-bat during the Boston Red Sox vs. the New York Yankees event is sent to the wager statistics module 51328. Then the wager module 51314 is continuously polled, at step 51408, for the wager statistics from the wager statistics module 51328. For example, the wager module 51314 continuously polls for the statistics on the sent wager, such as the percent of the wagers on J. D. Martinez hitting a single, double, triple, or home run from other users of the wagering app 51310. The wager module 51314 receives, at step 51410, the wager statistics from the wager statistics module 51328. For example, the wager module 51314 receives the sent wager statistics, such as the percent of the wagers on J. D. Martinez hitting a single, double, triple, home run, walk, strikeout, groundout, or fly out from other users of the wagering app 51310. Then the wager module 51314 displays, at step 51412, the wager statistics on the wagering app 51310. For example, the percentage of the wagers on J. D. Martinez hitting a single, double, triple, or home run from other users of the wagering app 51310 are displayed. Then it is determined, at step 51414, if the user selects to modify the wager. If it is determined that the user did not select to modify the wager, then the process returns to the user selecting a wagering market. If it is determined that the user selected to modify the wager, then the wager module 51314 initiates, at step 51416, the modify module 51316. For example, the user may wish to modify the confirmed wager of J. D. Martinez will hit a single in the first inning at-bat during the Boston Red Sox vs. the New York Yankees event after seeing the wager statistics. An instance may be if that there is a runner on second and first base is open, there may be greater odds that the result of at-bat would result in a walk and that most other users selected the walk wager and the user wants to modify the wager of the at-bat resulting in a single to take decreased odds on the next play in the event.

FIG. 515 illustrates the modify module 51316. The process begins with the modify module 51316 being initiated, at step 51500, by the wager module 51314. Then the modify module 51316 sends, at step 51502, the wager data to the wager adjustment module 51330. For example, the wager data may be the user ID, such as JS123456, the wagered amount, such as $20, and the wager, such as J. D. Martinez, will hit a single in the first inning at-bat during the Boston Red Sox vs. the New York Yankees event. Then the modify module 51316 continuously polls, at step 51504, for the cost to modify the wager, the wager amount remaining, and the odds for the next play. For example, the modify module 51316 continuously polls for the cost to modify the wager, such as $4.50, the wager amount remaining, such as $15.50, and the decreased odds for the next play. For example, during the next at-bat, the odds would be decreased 15% for Xander Bogaerts to hit a single, double, triple, home run, walk, strikeout, ground out, or flyout. The modify module 51316 receives, at step 51506, the cost to modify the wager, the wager amount remaining, and the odds for the next play. For example, the modify module 51316 receives the cost to modify the wager, such as $4.50, the wager amount remaining, such as $15.50, and the decreased odds for the next play. For example, during the next at-bat, the odds would be decreased 15% for Xander Bogaerts to hit a single, double, triple, home run, walk, strikeout, ground out, or flyout. Then the user selects, at step 308, the new wager. For example, the user selects that Xander Bogaerts will hit a single with the odds to decreased by 15% for $15.50 in the Boston Red Sox vs. the New York Yankees event. For example, if the original odds for Xander Bogaerts to hit a single were 6:1, then the user would be offered the odds 5.1:1 since the odds would be decreased by 15%. The user confirms, at step 51510, the new wager. For example, the user confirms the wager that Xander Bogaerts will hit a single with the odds to decreased by 15% for $15.50 in the Boston Red Sox vs. the New York Yankees event. For example, if the original odds for Xander Bogaerts to hit a single were 6:1, then the user would be offered the odds 5.1:1 since the odds would be decreased by 15%. Then the modify module 51316 sends, at step 51412, the new wager to the wager adjustment module 51330. For example, the modify module 51316 sends the wager that Xander Bogaerts will hit a single with the odds of 5.1:1 for $15.50 in the Boston Red Sox vs. the New York Yankees event. Then the modify module 51316 ends at step 51514.

FIG. 516 illustrates the wager statistics module 51328. The process begins with the wager statistics module 51328 continuously polling, at step 51600, for the wager data from the wager module 51314. For example, the wager statistics module 51328 continuously polls for the user's wager that J. D. Martinez will hit a single in the first inning at-bat during the Boston Red Sox vs. the New York Yankees event. Then the wager statistics module 51328 receives, at step 51602, the wager data from the wager module 51314. For example, the wager statistics module 51328 receives the wager that J. D. Martinez will hit a single in the first inning at-bat during the Boston Red Sox vs. the New York Yankees event. The wage statistics module 51328 determines, at step 51604, the wager statistics for the confirmed wager. For example, the wager statistics module 51328 may determine the number of users that placed a wager for J. D. Martinez to hit a single in the first inning in the Boston Red Sox vs. the New York Yankees event. The wager statistics module 51328 may determine this by filtering the odds database 51324 for all the wagers placed on the J. D. Martinez at-bat and counting one for each wager, then filter the wagers for the result to be J. D. Martinez hitting a single and count one for each wager, then divide the total amount of wagers resulting in a single by the total amount of wagers placed to determine the percentage of how many users wagered for J. D. Martinez to hit a single. In some embodiments, the statistics may be presented for all the possible outcomes of the at-bat, such as single, double, triple, home run, walk, strikeout ground out, or fly out and these may be calculated using the same method to determine the percentages of users that placed those wagers. In some embodiments, the statistics may involve how much money was wagered on each wager, the increase or decrease percentages of the odds since the wagers were offered, the amount of time the wagers have been offered, etc. Then the wager statistics module 51328 sends, at step 51606, the wager statistics to the wager module 51314, and the process returns to continuously polling for the wager data from the wager module 51314. For example, the wager statistics module 51328 sends the wager statistics, such as the percent of the wagers on J. D. Martinez hitting a single, double, triple, home run, walk, strikeout, groundout, or fly out other users of the wagering app 51310.

FIG. 517 illustrates the wager adjustment module 51330. The process begins with the wager adjustment module 51330 continuously polling, at step 51700, for the wager data from the modify module 51316. For example, the wager data may be the user ID, such as JS123456, the wagered amount, such as $20, and the wager, such as J. D. Martinez, will hit a single in the first inning at-bat during the Boston Red Sox vs. the New York Yankees event. Then the wager adjustment module 51330 receives, at step 51702, the wager data from the modify module 51316. For example, the wager data may be the user ID, such as JS123456, the wagered amount, such as $20, and the wager, such as J. D. Martinez, will hit a single in the first inning at-bat during the Boston Red Sox vs. the New York Yankees event. The wager adjustment module 51330 compares, at step 51704, the wager data to the modify database 51332. For example, the wager adjustment module 51330 compares the original wagered amount, such as $20, to the modify database 51332 to determine the corresponding cost to modify, such as $4.50, and the percentage to decrease the odds on the next play by, such as 15%. Then the wager adjustment module 51330 extracts, at step 51706, the cost for modifying the wager. For example, the wager adjustment module 51330 extracts the corresponding cost to modify the wager. For example, if the user wagered $20, the cost to modify would be $4.50. Then the wager adjustment module 51330 determines, at step 51708, the wager amount remaining. For example, the wager adjustment module 51330 subtracts the cost to modify, such as $4.50, from the original amount wagered, such as $20, resulting in a $15.50 amount remaining for the user to wager on the next play. The wager adjustment module 51330 extracts, at step 51710, the percentage to decrease the odds from the modify database 51332. For example, the wager adjustment module 51330 extracts the corresponding percentage to decrease the odds for the next play. For example, if the user wagered $20, the odds would decrease by 15% on the next play. Then the wager adjustment module 51330 extracts, at step 51712, the odds for the next wager in the odds database 51324. For example, the next play may the at-bat for Xander Bogaerts in the first inning in the Boston Red Sox vs. the New York Yankees, with the odds for Xander Bogaerts to hit a single being 6:1. In some embodiments, the odds may also include for Xander Bogaerts to hit a single, double, triple, home run, walk, strikeout, ground out, or flyout. The wager adjustment module 51330 determines, at step 51714, the new odds for the next wager. For example, if the odds for Xander Bogaerts to hit a single were 6:1, they would be decreased by 15%, creating new odds for user ID JS12345 of 5.1:1. Then the wager adjustment module 51330 sends, at step 51716, the cost for modifying the wager, the wager amount remaining, and the odds for the next wager to the modify module 51316. For example, the wager adjustment module 51330 the cost to modify the wager, such as $4.50, the wager amount remaining, such as $15.50, and the decreased odds for the next play. For example, during the next at-bat, the odds would be decreased 15% for Xander Bogaerts to hit a single, double, triple, home run, walk, strikeout, ground out, or flyout. The wager adjustment module 51330 continuously polls, at step 51718, for the new wager data from the modify module 51316. For example, the wager adjustment module 51330 is continuously polling for the new wager data, such as $15.50 on 5.1:1 for Xander Bogaerts to hit a single in the first inning of the Boston Red Sox vs. the New York Yankees event. Then the wager adjustment module 51330 receives, at step 51620, the new wager data from the modify module 51316. For example, the wager adjustment module 51330 receives the new wager data, such as $15.50 on 5.1:1 for Xander Bogaerts to hit a single in the first inning of the Boston Red Sox vs. the New York Yankees event. The wager adjustment module 51330 stores, at step 51722, the new wager data in the user database 51320, and the process returns to continuously polling for the wager data from the modify module 51316.

FIG. 518 illustrates the modify database 51332. The database contains the original wager amount, the cost to modify the wager, and the percentage to decrease the odds. In some embodiments, the cost to modify the wager may be a percentage of the original amount or a predetermined number. In some embodiments, the percentage to decrease the odds may be determined on the original odds; for example, the higher the odds, the more they are decreased. In some embodiments, the database may contain a list of available wagers that the user can wager to prevent the user from selecting wagers with uncommonly high odds. Finally, in some embodiments, the database may contain a limit on the number of times a user can modify a wager.

FIG. 519 a system for A.I.-based changes based on deviations from predictions, according to an embodiment.

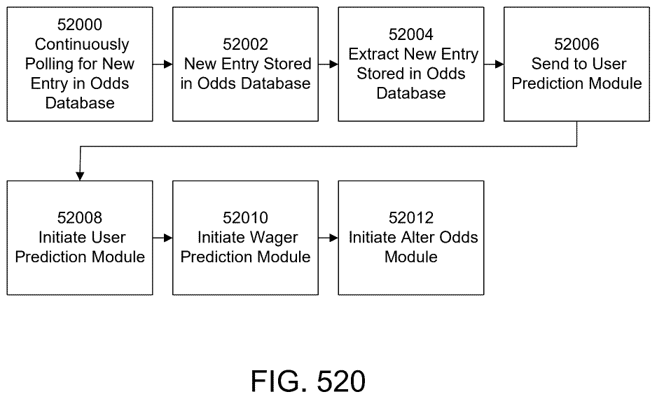

FIG. 520 illustrates a base module, according to an embodiment.

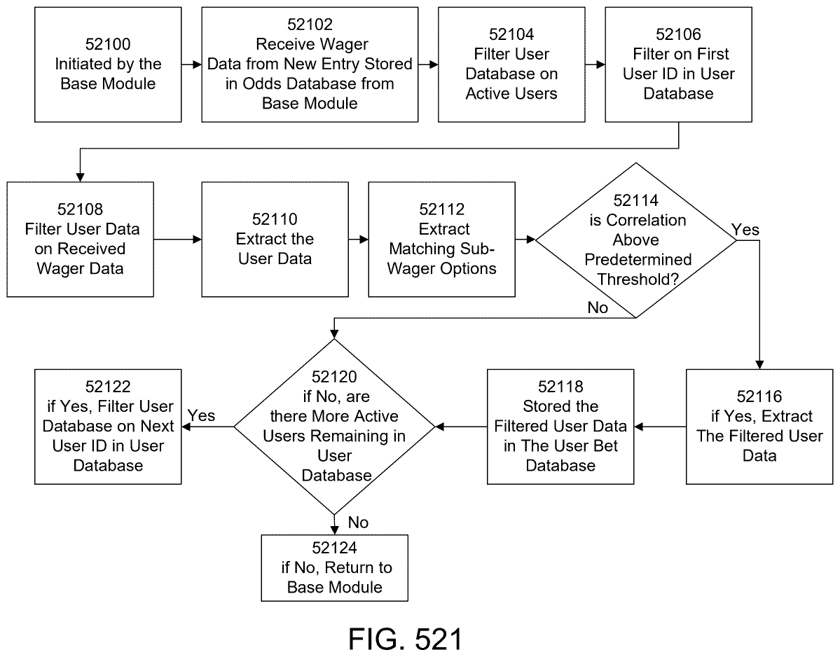

FIG. 521 illustrates a user prediction module, according to an embodiment.

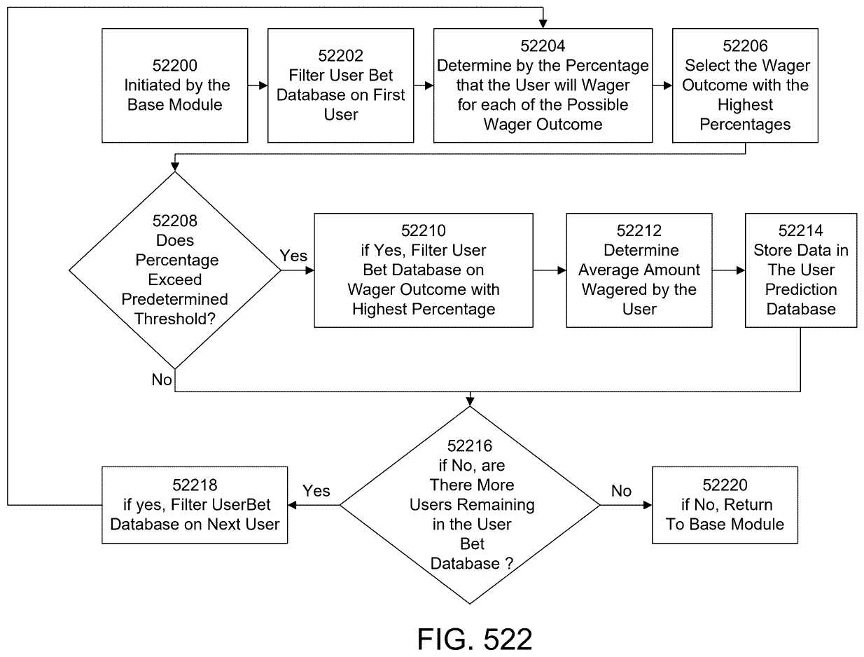

FIG. 522 illustrates a wager prediction module, according to an embodiment.

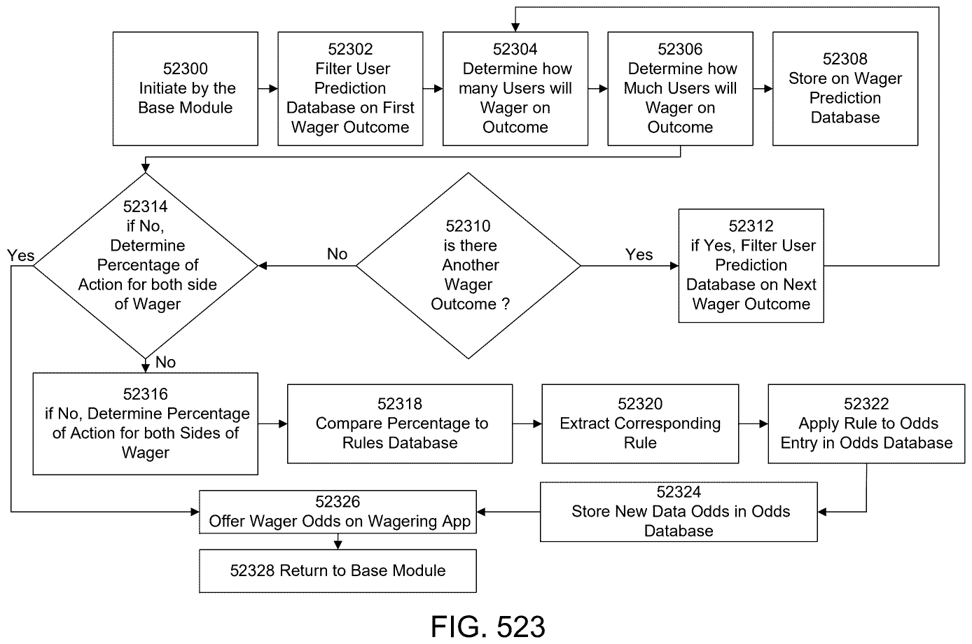

FIG. 523 illustrates an alter odds module, according to an embodiment.

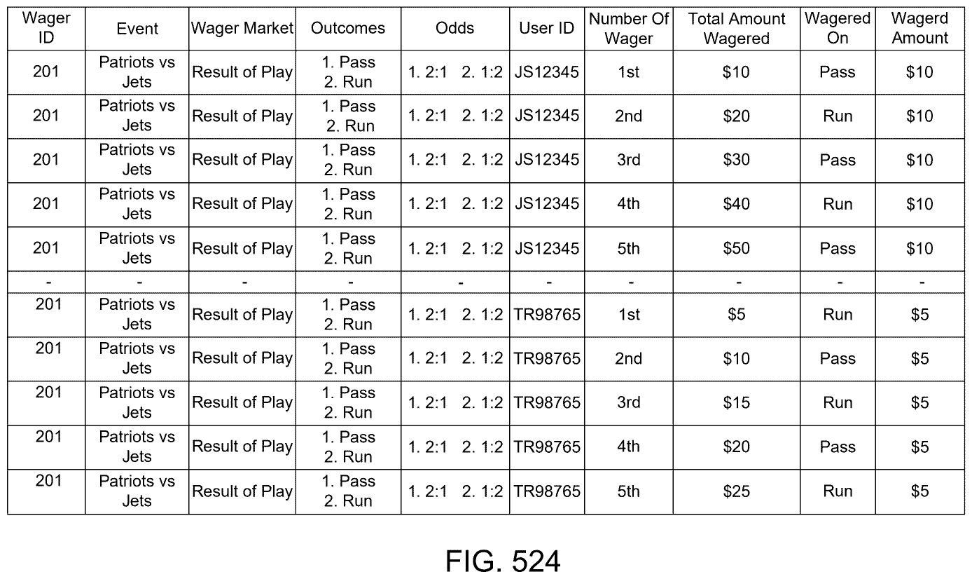

FIG. 524 illustrates a user bet database, according to an embodiment.

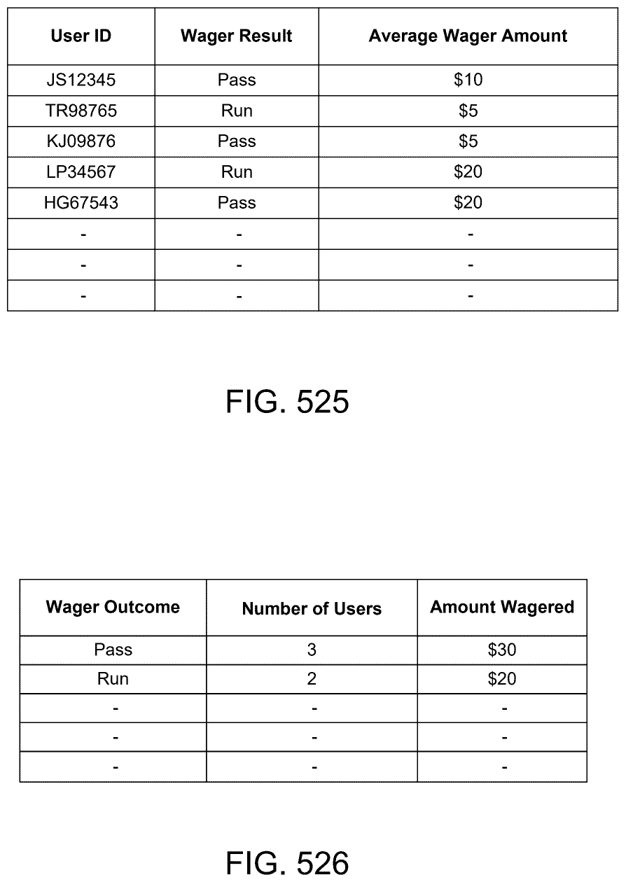

FIG. 525 illustrates a user prediction database, according to an embodiment.

FIG. 526 illustrates a wager prediction database, according to an embodiment.

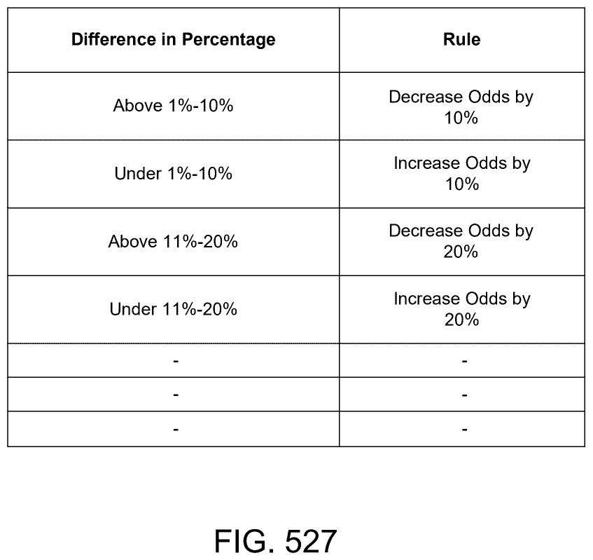

FIG. 527 illustrates a rules database, according to an embodiment.

FIG. 519 is a system for A.I.-based changes based on deviations from predictions. This system may include a live event 51902, for example, a sporting event such as a football, basketball, baseball, or hockey game, tennis match, golf tournament, eSports, or digital game, etc. The live event 51902 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team may need to cover if the result of the game with the same as the point spread the user may not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 51902, such as the score of an American football game or the run line in a baseball game, or a series of actions in the live event 51902. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 51902 or at another location.

Further, embodiments may include a plurality of sensors 51904 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 51904 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 51906 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 51906 may be communicatively coupled to a peer-to-peer wagering network 51914, which may perform real-time analysis on the type of play and the result of the play. The cloud 51906 may also be synchronized with game situational data such as the time of the game, the score, location on the field, weather conditions, and the like, which may affect the choice of play utilized. For example, in an exemplary embodiment, the cloud 51906 may not receive data gathered from the sensors 51904 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 51908 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 51908 could be an optional component and may be utilized in a situation where a paired wearable device employs the mobile device 51908 for additional memory or computing power or connection to the internet.

Further, embodiments may include a wagering software application or a wagering app 51910, which is a program that enables the user to place bets on individual plays in the live event 51902, streams audio and video from the live event 51902, and features the available wagers from the live event 51902 on the mobile device 51908. The wagering app 51910 allows the user to interact with the wagering network 51914 to place bets and provide payment/receive funds based on wager outcomes.

Further, embodiments may include a mobile device database 51912 that may store some or all the user's data, the live event 51902, or the user's interaction with the wagering network 51914.

Further, embodiments may include the wagering network 51914, which may perform real-time analysis on the type of play and the result of a play or action. The wagering network 51914 (or the cloud 51906) may also be synchronized with game situational data, such as the time of the game, the score, location on the field, weather conditions, and the like, which may affect the choice of play utilized. For example, in an exemplary embodiment, the wagering network 51914 may not receive data gathered from the sensors 51904 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 51914 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 51916, which may contain data relevant to all users of the wagering network 51914 and may include, but is not limited to, a user ID, a device identifier, a paired device identifier, wagering history, or wallet information for the user. The user database 51916 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 51916 may contain betting lines and search queries. The user database 51916 may be searched based on a search criterion received from the user. Each betting line may include but is not limited to, a plurality of betting attributes such as at least one of the following: the live event 51902, a team, a player, an amount of wager, etc. The user database 51916 may include, but is not limited to, information related to all the users involved in the live event 51902. In one exemplary embodiment, the user database 51916 may include information for generating a user authenticity report and a wagering verification report. Further, the user database 51916 may be used to store user statistics like, but not limited to, the retention period for a particular user, frequency of wagers placed by a particular user, the average amount of wager placed by each user, etc.

Further, embodiments may include a historical plays database 51918 that may contain play data for the type of sport being played in the live event 51902. For example, in American Football, for optimal odds calculation, the historical play data may include metadata about the historical plays, such as time, location, weather, previous plays, opponent, physiological data, etc.

Further, embodiments may utilize an odds database 51920—that may contain the odds calculated by an odds calculation module 51922—to display the odds on the user's mobile device 51908 and take bets from the user through the mobile device wagering app 51910.

Further, embodiments may include the calculation module 51922, which may utilize historical play data to calculate odds for in-play wagers.may bemay contain

Further, embodiments may include a base module 51924, which may begin with the base module 51924 continuously polling for a new entry to be stored in the odds database 51920. Then a new entry may be stored in the odds database 51920. Next, the base module 51924 may extract the new entry stored in the odds database 51920. Then the base module 51924 may send the wager data from the new entry stored in the odds database 51920 to the user prediction module 51926. Then the base module 51924 may initiate the user prediction module 51926. The base module 51924 may initiate the wager prediction module 51928. Then the base module 51924 may initiate the alter odds module 51930, and the process may return to continuously poll for a new entry to be stored in the odds database 51920.

Further, embodiments may include a user prediction module 51926, which may begin with the user prediction module 51926 being initiated by the base module 51924. The user prediction module 51926 may receive the wager data from the new entry stored in the odds database 51920 from the base module 51924. Then the user prediction module 51926 may filter the user database 51916 on the active users. The user prediction module 51926 may filter the user database 51916 on the first user I.D. currently active on the wagering network 51914. Then the user prediction module 51926 may filter the user database 51916 on the received wager data from the new entry stored in the odds database 51920 from the base module 51924. Then the user prediction module 51926 may extract the user data stored in the user database 51916 that has been filtered by the active users on the wagering network 51914, the user I.D., and the received wager data from the new entry stored in the odds database 118. The user prediction module 51926 may perform correlations on the extracted data. Then the user prediction module 51926 may determine if the correlations are above a predetermined threshold. If the correlations are above the predetermined threshold, then the user prediction module 51926 may extract the filtered user data. Then the user prediction module 51926 may store the filtered user data in the user bet database 51932. If the correlations are not above the predetermined threshold or after the filtered user data is stored in the user bet database 51932, the user prediction module 51926 may determine if there are more active users remaining on the wagering network 51914. If there are more active users remaining on the wagering network, the user prediction module 51926 may filter the user database 51916 on the next user I.D., and the process may return to further filtering the user database 51916 on the received wager data of the new entry stored in the odds database 51920. If there are no more active users remaining on the wagering network 51914, then the user prediction module 51926 may return to the base module 51924.

Further, embodiments may include a wager prediction module 51928, which may begin with the wager prediction module 51928 being initiated by the base module 51924. Then the wager prediction module 51928 may filter the user bet database 51932 on the first user I.D. Then the wager prediction module 51928 may determine the percentage that the user will wager on each possible wager outcome. Then the wager prediction module 51928 may select the wager outcome with the highest percentage. Then the wager prediction module 51928 may determine if the percentage exceeds the predetermined threshold. If the percentage exceeds the predetermined threshold, then the wager prediction module 51928 may filter the user bet database 51932 on the wager outcome with the highest percentage. Then the wager prediction module 51928 may determine the average amount wagered by the user on the wager outcome with the highest percentage. The wager prediction module 51928 may store the data in the user prediction database 51934. If the percentage does not exceed the predetermined threshold or after the data is stored in the user prediction database 51934, the wager prediction module 51928 may determine if more users remain in the user bet database 51932. If more users remain in the user bet database 51932, then the wager prediction module 51928 may filter the user bet database 51932 on the next user I.D., and the process may return to determining the percentage that the user will wager for each of the possible wager outcomes. If no more users remain in the user bet database 51932, the wager prediction module 51928 may return to the base module 51924.

Further, embodiments may include an alter odds module 51930, which may begin with the alter odds module 51930 initiated by the base module 51924. The alter odds module 51930 may filter the user prediction database 51936 on the first wager outcome. Then the alter odds module 51930 may determine how many users will wager on the wager outcome. Then the alter odds module 51930 may determine how much the users will wager on the wager outcome. The alter odds module 51930 may store how many users will wager and how much the users will wager in the wager prediction database 51936. Then the alter odds module 51930 may determine if another wager outcome is stored in the user prediction database 51934. If there is another wager outcome stored in the user prediction database 51934, then the alter odds module 51930 may filter the user prediction database 51934 on the next wager outcome, and the process may return to determine how many users will wager on the wager outcome. If no more wager outcomes remain in the user prediction database 51934, then the alter odds module 51930 may determine if there is even action on both sides of the wager. If there is not even action on both sides of the wager, then the alter odds module 51930 may determine the percentages for action for both sides of the wager. Then the alter odds module 51930 may compare the difference in the percentages to the rules database 51938. Next, the alter odds module 51930 may extract the corresponding rule stored in the rules database 51938. Then the alter odds module 51930 may apply the extracted rule to the wager odds for the new entry stored in the odds database 51920. Then the alter odds module 51930 may store the new odds for the wager in the odds database 51920. If there is even action on both sides of the wager or after the new odds are stored in the odds database 51920, then the alter odds module 51930 may offer the wager odds on the wagering app 51910. Then the alter odds module 51930 may return to the base module 51924.

Further, embodiments may include a user bet database 51932, which may contain the wager I.D., the event, the wagering market, the possible outcomes for the wager, the odds for the wager, the user I.D., the number of the wager in sequential order, the total amount wagered, the outcome wagered on, and the amount wagered for the wager. For example, the user bet database 51932 may store the wager data from the odds database 51920 such as the wager I.D., such as 201, the event, such as the New England Patriots vs. the New York Jets, the outcomes for the wager, such as the first outcome being a pass and the second outcome being a run, and the odds for the possible outcomes, such as the odds of 2:1 for the outcome to be a pass and the odds 1:2 for the outcome to be a run. For example, the user bet database 51932 may store the filtered user data from the user database 51916 as described in the user prediction module 51926, which may contain the user I.D., such as JS12345, the number of the wager in sequential order, such the users first wager, second wager, third wager, etc., the total amount wagered up to that point in time, such as $10 wagered total, $20 wagered total, etc., the outcome that the user wagered on, such as pass or run, and the amount that the user wagered on that individual wager, such as $10. In some embodiments, the user bet database 51932 may contain the correlation coefficients calculated during the user prediction module 51926. In some embodiments, the user bet database 51932 may contain the predetermined threshold of the correlation coefficient to determine if the data should be stored in the database or not.

Further, embodiments may include a user prediction database 51934, which may contain the user I.D., the wager result, and the average amount wagered and is created during the process described in the wager prediction module 51928 and may be used in the process described in the alter odds module 51930. For example, the database may contain the user I.D., such as JS12345, the wager result, such as pass, and the average amount wagered by the user, such as $10.

Further, embodiments may include a wager prediction database 51936, which may be created in the process described in the alter odds module 51930 and may contain the wager outcome, such as pass, the number of users that will wager on that outcome, such as three users will wager on a pass, and the amount wagered on the outcome, such as there will be $30 wagered on a pass. Finally, in some embodiments, there may be additional wager outcomes in which the process described in the alter odds module 51930 may determine, for each possible wager outcome, the number of users that will wager on the wager outcome and the amount that may be wagered on the wager outcome.

Further, embodiments may include a rules database 51938 that may contain the difference in percentages between the possible wager outcomes and the rule applied to the wagering odds. For example, if there are two possible wager outcomes, such as pass and run, and there is 60% of the money on the pass wagers and only 40% of the money on run wagers, there is not even action on both sides of the wager, an ideal percentage may be 50% of wagers or money on one side and 50% of wagers or money on the other side. So, the difference in percentages may be 20%, so the 2:1 odds for a pass may be above 20%, and the corresponding rule may be to decrease the odds by 20% so that the 2:1 odds for a pass may drop to 1.6:1 odds for the outcome to be a pass. Likewise, the difference may be under 20% for the run wager, and the odds for a run may be altered from 1:2 odds to 1:1.6 odds since the corresponding rule may be to increase the odds by 20%.

FIG. 520 illustrates the base module 51924. The process may begin with the base module 51924 continuously polling, at step 52000, for a new entry to be stored in the odds database 51920. For example, the base module 51924 may be polling for the odds calculation module 51922 to create and store the new wager data, such as the wager odds, in the odds database 51920. For example, for the event such as the New England Patriots vs. the New York Jets, for the wagering market of the result of the upcoming play, the wager outcomes may be a pass or run with the odds of 2:1 for the result to be a pass and the odds of 1:2 for the result to be a run. Then a new entry may be stored, at step 52002, in the odds database 51920 by the base module 51924. For example, for the event such as the New England Patriots vs. the New York Jets, for the wagering market of the result of the upcoming play, the wager outcomes may be a pass or run with the odds of 2:1 for the result to be a pass and the odds of 1:2 for the result to be a run. The base module 51924 may extract, at step 52004, the new entry stored in the odds database 51920. For example, the base module 51924 may extract the data such as the New England Patriots vs. the New York Jets, for the wagering market of the result of the upcoming play, the wager outcomes may be a pass or run with the odds of 2:1 for the result to be a pass and the odds of 1:2 for the result to be a run from the odds database 51920. Then the base module 51924 may send, at step 52006, the wager data from the new entry stored in the odds database 51920 to the user prediction module 51926. For example, the base module 51924 may send the extracted wager data from the odds database 52020, such as the New England Patriots vs. the New York Jets, for the wagering market of the result of the upcoming play, the wager outcomes may be a pass or run with the odds of 2:1 for the result to be a pass and the odds of 1:2 for the result to be a run. Then the base module 51924 may initiate, at step 52008, the user prediction module 51926. For example, the user prediction module 51926 may begin with the user prediction module 51926 being initiated by the base module 51924. The user prediction module 51926 may receive the wager data from the new entry stored in the odds database 51920 from the base module 51924. Then the user prediction module 51926 may filter the user database 51916 on the active users. The user prediction module 51926 may filter the user database 51916 on the first user I.D. currently active on the wagering network 51914. Then the user prediction module 51926 may filter the user database 51916 on the received wager data from the new entry stored in the odds database 51920 from the base module 51924. Then the user prediction module 51926 may extract the user data stored in the user database 51916 that has been filtered by the active users on the wagering network 51914, the user I.D., and the received wager data from the new entry stored in the odds database 51920. The user prediction module 51926 may perform correlations on the extracted data. Then the user prediction module 51926 may determine if the correlations are above a predetermined threshold. If the correlations are above the predetermined threshold, then the user prediction module 51926 may extract the filtered user data. Then the user prediction module 51926 may store the filtered user data in the user bet database 51932. If the correlations are not above the predetermined threshold or after the filtered user data may be stored in the user bet database 51932, the user prediction module 51926 may determine if there are more active users remaining on the wagering network 51914. If there are more active users remaining on the wagering network, the user prediction module 51926 may filter the user database 51916 on the next user I.D., and the process may return to further filtering the user database 51916 on the received wager data of the new entry stored in the odds database 51918. If there are no more active users remaining on the wagering network 51914, then the user prediction module 51926 may return to the base module 51924. The base module 51924 may initiate, at step 52010, the wager prediction module 51928. For example, the wager prediction module 51928 may begin with the wager prediction module 51928 being initiated by the base module 51924. Then the wager prediction module 51928 may filter the user bet database 51932 on the first user I.D. Then the wager prediction module 51928 may determine the percentage that the user will wager on each possible wager outcome. Then the wager prediction module 51928 may select the wager outcome with the highest percentage. Then the wager prediction module 51928 may determine if the percentage exceeds the predetermined threshold. If the percentage exceeds the predetermined threshold, then the wager prediction module 51928 may filter the user bet database 51932 on the wager outcome with the highest percentage. Then the wager prediction module 51928 may determine the average amount wagered by the user on the wager outcome with the highest percentage. The wager prediction module 51928 may store the data in the user prediction database 51934. If the percentage does not exceed the predetermined threshold or after the data may be stored in the user prediction database 51934, the wager prediction module 51928 may determine if more users are remaining in the user bet database 51932. If more users are remaining in the user bet database 51932, then the wager prediction module 51928 may filter the user bet database 51932 on the next user I.D., and the process may return to determining the percentage that the user will wager for each of the possible wager outcomes. If there are no more users remaining in the user bet database 51932, the wager prediction module 51928 may return to the base module 51924. Then the base module 51924 may initiate, at step 52012, the alter odds module 51930, and the process may return to continuously polling for a new entry to be stored in the odds database 51920. For example, the alter odds module 51930 may begin with the alter odds module 51930 being initiated by the base module 51924. The alter odds module 51930 may filter the user prediction database 51934 on the first wager outcome. Then the alter odds module 51930 may determine how many users will wager on the wager outcome. Then the alter odds module 51930 may determine how much the users will wager on the wager outcome. The alter odds module 51930 may store how many users will wager and how much the users will wager in the wager prediction database 51936. Then the alter odds module 51930 may determine if another wager outcome may be stored in the user prediction database 51934. If there is another wager outcome stored in the user prediction database 51934, then the alter odds module 51930 may filter the user prediction database 51934 on the next wager outcome, and the process may return to determine how many users will wager on the wager outcome. If no more wager outcomes are remaining in the user prediction database 51934, then the alter odds module 51930 may determine if there is even action on both sides of the wager. If there is not even action on both sides of the wager, then the alter odds module 51930 may determine the percentages for action for both sides of the wager. Then the alter odds module 51930 may compare the difference in the percentages to the rules database 51938. The alter odds module 51930 may extract the corresponding rule stored in the rules database 51938. Then the alter odds module 51930 may apply the extracted rule to the wager odds for the new entry stored in the odds database 51920. Then the alter odds module 51930 may store the new odds for the wager in the odds database 51920. If there is even action on both sides of the wager or after the new odds are stored in the odds database 51920, then the alter odds module 51930 may offer the wager odds on the wagering app 51910. Then the alter odds module 51930 may return to the base module 51924.

FIG. 521 illustrates the user prediction module 51926. The process may begin with the user prediction module 51926 being initiated, at step 52100, by the base module 51924. The user prediction module 51926 may receive, at step 52102, the wager data from the new entry stored in the odds database 51920 from the base module 51924. For example, the wager data from a new entry stored in the odds database 51920 may be the wager I.D., such as 201, the event, such as the New England Patriots vs. the New York Jets, the wagering market, such as the result of the play, the wager outcomes, such as the first outcome option being a pass and the second outcome option being a run, the odds for the wager outcomes, such as 2:1 odds for a pass and 1:2 odds for a run. In some embodiments, the wager data may contain the current time, the time in the event, the players participating in the play, the weather conditions at the event, etc. Then the user prediction module 51926 may filter, at step 52104, the user database 51916 on the active users. For example, the user prediction module 51926 may filter the user database 51916 on all the users that are currently on, are engaged, are signed in, are actively wagering, etc., on the wagering app 51910 through the wagering network 51914. The user prediction module 51926 may filter, at step 52106, the user database 51916 on the first user I.D. that is currently active on the wagering network 51914. For example, the user prediction module 51916 may filter the user database 51916 for the first user I.D., such as JS12345, active on the wagering network 51914. Then the user prediction module 51926 may filter, at step 52108, the user database 51916 on the received wager data from the new entry stored in the odds database 51920 from the base module 51924. For example, the user prediction module 51926 further may filter the user database 51916 for the active user, such as JS12345, and the received wager data, such as the historical data in which user JS12345 has wagered on the event, such as the New England Patriots vs. the New York Jets, and has wagered on the wagering market, such as the result of the play, with the wager outcomes, such as pass and run, containing the same odds, such as 2:1 odds for a pass and 1:2 odds for a run. Then the user prediction module 51926 may extract, at step 52110, the user data stored in the user database 51916 that has been filtered by the active users on the wagering network 51914, the user I.D., and the received wager data from the new entry stored in the odds database 51920. For example, the data that is extracted may be the historical data in which the active user has wagered on the event, such as the New England Patriots vs. the New York Jets, and has wagered on the wagering market, such as the result of the play, with the wager outcomes, such as pass and run, containing the same odds, such as 2:1 odds for a pass and 1:2 odds for a run. The user prediction module 51926 may perform, at step 52112, correlations on the extracted data. For example, the extracted data may be for the historical instances in which the active user wagered matching the received wager data, such as the event, wager market, wager outcomes, and wager odds, and then correlations are performed on the number of the wager confirmed by the user, such as the user's first wager, second wager, third wager, etc. and the total amount wagered by the user in that situation. An example of correlated parameters may be with the number of wagers vs. total amount wagered with a 0.97 correlation coefficient, and the filtered user data may be extracted and stored in the user bet database 51932, for example, the number of the wager, such as first, second, third, etc., the total amount wagered, the wager outcome that the user wagered on in that instance, such as pass or run, and the wagered amount for each wager, such as $10. Then the user prediction module 51926 may determine, at step 52114, if the correlations are above a predetermined threshold. For example, the predetermined threshold may be set at a 0.90 correlation coefficient to determine if the user's data is highly correlated enough to predict that the user has consistently wagered on the wagering market, allowing the user prediction module 51926 to determine that the user's data is relevant for predicting the upcoming action on the new wager data entry stored in odds database 51920 to ensure that the wagering network 51914 provides wager odds to allow for an even 50/50 split of money from users being wagered on both sides of the wager. If the correlations are above the predetermined threshold, then the user prediction module 51926 may extract, at step 52116, the filtered user data. For example, if the correlation coefficient is above 0.90, such as a correlation coefficient of 0.97, then the filtered user data may be extracted. For example, the data may be the number of the wager, such as first, second, third, etc., the total amount wagered, the wager outcome that the user wagered on in that instance, such as pass or run, and the wagered amount for each wager, such as $10. Then the user prediction module 51926 may store, at step 52118, the filtered user data in the user bet database 51932. For example, the user prediction module 51926 may store the filtered user data, such as the number of the wager, such as first, second, third, etc., the total amount wagered, the wager outcome that the user wagered on in that instance, such as pass or run, and the wagered amount for each wager, such as $10. If the correlations are not above the predetermined threshold or after the filtered user data may be stored in the user bet database 51932, the user prediction module 51926 may determine, at step 52120, if there are more active users remaining on the wagering network 51914. If the correlation coefficient does not exceed the predetermined threshold, such as 0.90 correlation coefficient. In that case, the user prediction module 51926 can determine that the user has not consistently wagered on the wagering market with the specific wager odds, and thus the user's data may not be relevant to predict the upcoming action for the new wager data stored in the odds database 51920. If there are more active users remaining on the wagering network, the user prediction module 51926 may filter, at step 52122, the user database 51916 on the next user I.D., and the process may return to further filtering the user database 51916 on the received wager data of the new entry stored in the odds database 51920. For example, the user prediction module 51926 may filter the user database 51916 on the next active user, such as TR98765, and the process may filter the user database 51916 on the received wager data from the new entry to perform the correlations on the next user's data. If there are no more active users remaining on the wagering network 51914, then the user prediction module 51926 may return, at step 52124, to the base module 51924.

FIG. 522 illustrates the wager prediction module 51928. The process may begin with the wager prediction module 51928 being initiated, at step 52200, by the base module 51924. Then the wager prediction module 51928 may filter; at step 52202, the user bet database 51932 on the first user I.D. For example, the wager prediction module 51928 may filter the user bet database 51932 on the user ID JS12345. Then the wager prediction module 51928 may determine, at step 52204, the percentage that the user will wager on each possible wager outcome. For example, if the wager outcomes are either pass or run the wager prediction module 51928, the percentage chance that the user will wager on a pass and the percentage chance that the user will wager on a run using the user's historical data stored in the user bet database 51932. For example, if the user has completed five total wagers for the specific wager market and has wagered three times on pass and two times on a run, the percentages may be 60% for a pass and 40% for a run. Then the wager prediction module 51928 may select, at step 52206, the wager outcome with the highest percentage. For example, if the user has a 60% chance of wagering on a pass and a 40% chance of wagering on a run, then the pass wager outcome may be selected. Then the wager prediction module 51928 may determine, at step 52208, if the percentage exceeds the predetermined threshold. For example, there may be a predetermined threshold, such as 55%, to determine if the user consistently wagers on a specific wager outcome, such as pass. If the percentage is below the predetermined threshold, it may be determined that the user consistently wagers on both sides of the wager outcomes and thus cannot be used for prediction purposes. If the percentage exceeds the predetermined threshold, then the wager prediction module 51928 may filter, at step 52210, the user bet database 51932 on the wager outcome with the highest percentage. For example, if the selected wager outcome were a pass, then the user bet database 51932 may be filtered on the user I.D., such as JS12345, and the wager outcome, such as pass. Then the wager prediction module 51928 may determine, at step 52212, the average amount wagered by the user on the wager outcome with the highest percentage. For example, the wager prediction module 51928 may count the number of times the user wagered on the outcome, such as three, and the total amount wagered by the user. For example, if the user wagered $10 on every wager, their total wagered amount may be $30 and the wager prediction module 51928 may divide the three times wagered by the $30 wagered total to determine the average wager amount of $10. The wager prediction module 51928 may store, at step 52214, the data in the user prediction database 51934. For example, the wager prediction module 51928 may store the user I.D., such as JS12345, the wager outcome or wager result, such as pass, and the average amount wagered, such as $10, in the user prediction database 51934. If the percentage does not exceed the predetermined threshold or after the data may be stored in the user prediction database 51934, the wager prediction module 51928 may determine, at step 52216, if more users are remaining in the user bet database 51932. For example, if the percentage is below the predetermined threshold, it may be determined that the user consistently wagers on both sides of the wager outcomes and thus cannot be used for prediction purposes. If more users are remaining in the user bet database 51932, then the wager prediction module 51928 may filter, at step 52218, the user bet database 51932 on the next user I.D., and the process may return to determining the percentage that the user will wager for each of the possible wager outcomes. If there are no more users remaining in the user bet database 51932, the wager prediction module 51928 may return, at step 52220, to the base module 51924.

FIG. 523 illustrates the alter odds module 51930. The process may begin with the alter odds module 51930 being initiated, at step 52300, by the base module 51924. The alter odds module 51930 may filter, at step 52302, the user prediction database 51934 on the first wager outcome. For example, the alter odds module 51930 may filter the user prediction database 51934 on the first wager outcome or wager result, such as pass. Then the alter odds module 51930 may determine, at step 52304, how many users will wager on the wager outcome. For example, the alter odds module 51930 may count how many users are in the filtered user prediction database 51934 to determine how many users will wager on the outcome of a pass. Then the alter odds module 51930 may determine, at step 52306, how much the users will wager on the wager outcome. For example, the alter odds module 51930 may count the average wager amount for each user to determine the total amount that will be wagered on the wager outcome being a pass. 506. The alter odds module 51930 may store, at step 52308, how many users will wager and how much the users will wager in the wager prediction database 51936. For example, the alter odds module may store the number of users, such as 3, the amount that will be wagered by those users, such as $30, in the wager prediction database 51936. Then the alter odds module 51930 may determine, at step 52310, if another wager outcome may be stored in the user prediction database 51934. For example, if there is another wager outcome, such as run, then the alter odds module 51930 will filter the user prediction database 51934 on the wager outcome being a run. If there is another wager outcome stored in the user prediction database 51934, then the alter odds module 51930 may filter, at step 52312, the user prediction database 51934 on the next wager outcome, and the process may return to determine how many users will wager on the wager outcome. If no more wager outcomes remain in the user prediction database 51934, then the alter odds module 51930 may determine, at step 52314, if there is even action on both sides of the wager. For example, if there is a prediction that there will be $30 on the wager outcome being a pass and $20 on the wager outcome being a run, there would not be even action on the wager. Ideally, wagering platforms and wagering applications desire to get even amounts of money on both sides of a wager, known as getting even action on a wager. If there is not even action on both sides of the wager, then the alter odds module 51930 may determine, at step 52316, the percentages for action for both sides of the wager. For example, if there is a prediction that there will be $30 on the wager outcome being a pass and $20 on the wager outcome being a run, then that may be 60% of the money on a pass and only 40% of the money being wagered on a run, which for the pass outcome may be above 20% and for the run outcome that may be below 20%. Then the alter odds module 51930 may compare, at step 52318, the difference in the percentages to the rules database 51938. For example, the alter odds module 51930 may compare the above 20% for the outcome being a pass and below 20% for the outcome being a run to the rules database 51938. For example, if there are two possible wager outcomes, such as pass and run, and there is 60% of the money on the pass wagers and only 40% of the money on run wagers, there is not even action on both sides of the wager, an ideal percentage may be 50% of wagers or money on one side and 50% of wagers or money on the other side. So, the difference in percentages may be 20%, so the 2:1 odds for a pass may be above 20%, and the corresponding rule may be to decrease the odds by 20% so that the 2:1 odds for a pass may drop to 1.6:1 odds for the outcome to be a pass. The difference may be under 20% for the run wager, and the odds for a run may be altered from 1:2 odds to 1:1.6 odds since the corresponding rule may be to increase the odds by 20%. The alter odds module 51930 may extract, at step 52320, the corresponding rule stored in the rules database 51938. For example, the extracted rule may be that the wager odds for the wager outcome being a pass should have the odds decreased by 20%, and the wager odds for the wager outcome being a run may be to increase the odds by 20%. Then the alter odds module 51930 may apply, at step 52322, the extracted rule to the wager odds for the new entry stored in the odds database 51920. For example, the original 2:1 odds for a pass may decrease by 20% to 1.6:1 odds for the outcome to be a pass, and the original 1:2 odds for a run may increase by 20% to 1:1.6 odds for the outcome to be run. Then the alter odds module 51930 may store, at step 52324, the new odds for the wager in the odds database 51920. For example, the alter odds module 51930 may store the wager odds of the 1.6:1 for a pass and 1:1.6 for a run in the odds database 51920, updating the wager data stored for the new entry. If there is even action on both sides of the wager or after the new odds are stored in the odds database 51920, then the alter odds module 51930 may offer, at step 52326, the wager odds on the wagering app 51910. Then the alter odds module 51930 may return, at step 52328, to the base module 51924.

FIG. 524 illustrates the user bet database 51932. The database may contain the wager I.D., the event, the wagering market, the possible outcomes for the wager, the odds for the wager, the user I.D., the number of the wager in sequential order, the total amount wagered, the outcome wagered on, and the amount wagered for the wager. For example, the user bet database 51932 may store the wager data from the odds database 51920 such as the wager I.D., such as 201, the event, such as the New England Patriots vs. the New York Jets, the outcomes for the wager, such as the first outcome being a pass and the second outcome being a run, and the odds for the possible outcomes, such as the odds of 2:1 for the outcome to be a pass and the odds 1:2 for the outcome to be a run. For example, the user bet database 51932 may store the filtered user data from the user database 51916 as described in the user prediction module 51926, which may contain the user I.D., such as JS12345, the number of the wager in sequential order, such the users first wager, second wager, third wager, etc., the total amount wagered up to that point in time, such as $10 wagered total, $20 wagered total, etc., the outcome that the user wagered on, such as pass or run, and the amount that the user wagered on that individual wager, such as $10. In some embodiments, the user bet database 51932 may contain the correlation coefficients calculated during the user prediction module 51926. In some embodiments, the user bet database 51932 may contain the predetermined threshold of the correlation coefficient to determine if the data should be stored in the database or not.

FIG. 525 illustrates the user prediction database 51934. The database may contain the user I.D., the wager result, and the average amount wagered and is created during the process described in the wager prediction module 51928 and is used in the process described in the alter odds module 51930. For example, the database may contain the user I.D., such as JS12345, the wager result, such as pass, and the average amount wagered by the user, such as $10.

FIG. 526 illustrates the wager prediction database 51936. The database may be created in the process described in the alter odds module 51930 and may contain the wager outcome, such as pass, the number of users that will wager on that outcome, such as three users will wager on a pass, and the amount wagered on the outcome, such as there will be $30 wagered on a pass. In addition, in some embodiments, there may be additional wager outcomes in which the process described in the alter odds module 51930 will determine, for each possible wager outcome, the number of users that will wager on the wager outcome and the amount that will be wagered on the wager outcome.

FIG. 527 illustrates the rules database 51938. The database may contain the difference in percentages between the possible wager outcomes and the rule which should be applied to the wagering odds. For example, if there are two possible wager outcomes, such as pass and run, and there is 60% of the money on the pass wagers and only 40% of the money on run wagers, there is not even action on both sides of the wager, an ideal percentage may be 50% of wagers or money on one side and 50% of wagers or money on the other side. So, the difference in percentages may be 20%, so the 2:1 odds for a pass may be above 20%, and the corresponding rule may be to decrease the odds by 20% so that the 2:1 odds for a pass may drop to 1.6:1 odds for the outcome to be a pass. The difference may be under 20% for the run wager, and the odds for a run may be altered from 1:2 odds to 1:1.6 odds since the corresponding rule may be to increase the odds by 20%.

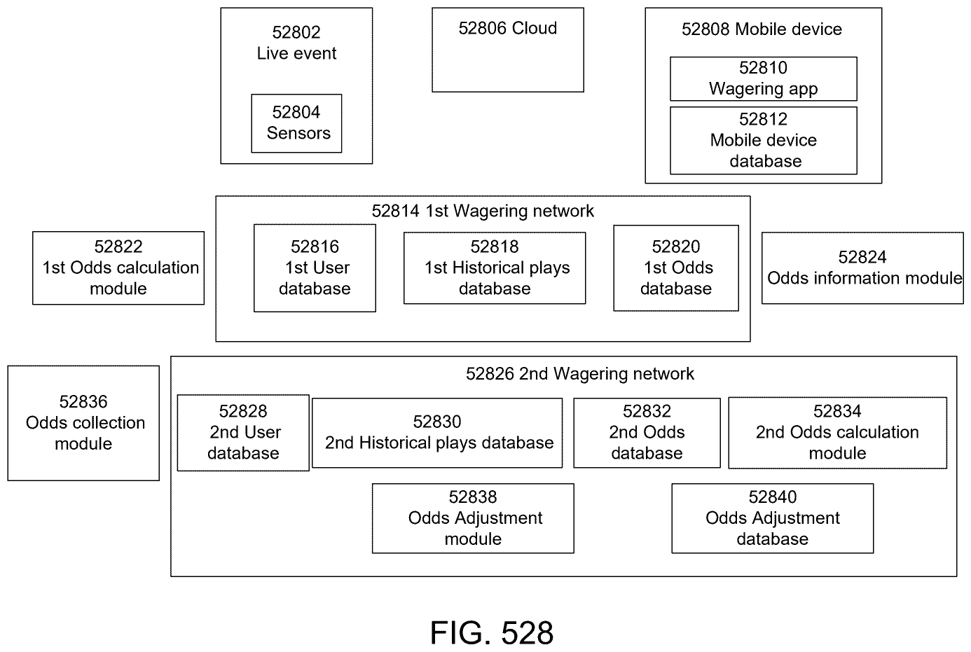

FIG. 528 illustrates a system for calculating and storing the odds data on a first wagering network and adjusting odds on a second wagering network based on the odds data from the first wagering network, according to an embodiment.

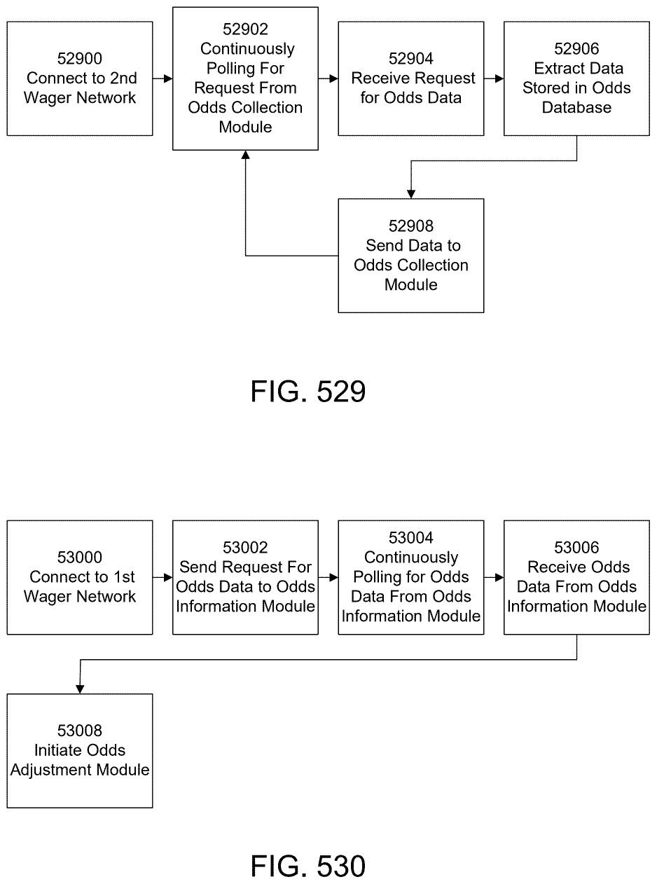

FIG. 529 illustrates an odds information module, according to an embodiment.

FIG. 530 illustrates an odds collection module, according to an embodiment.

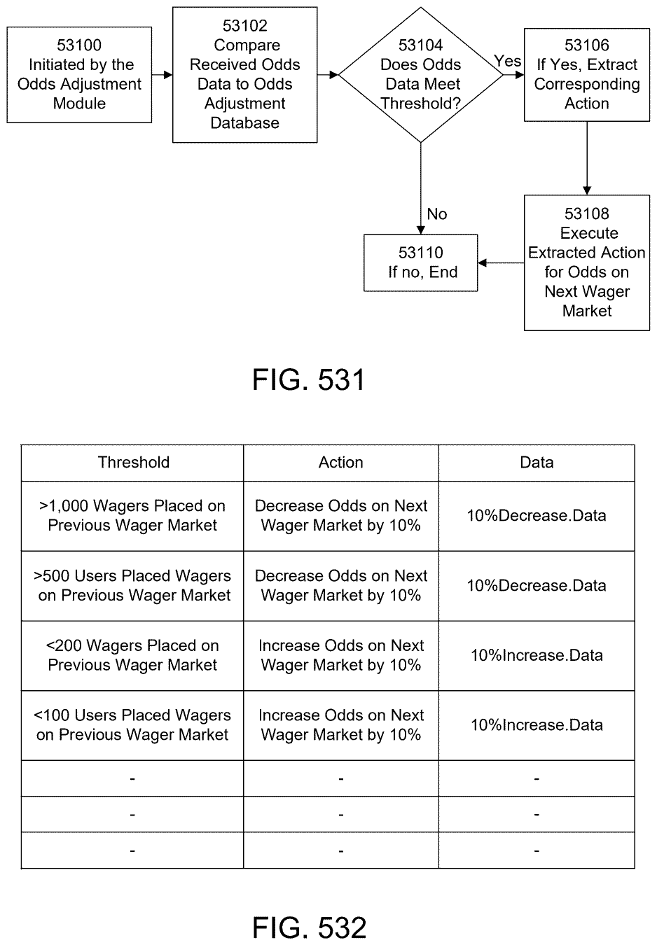

FIG. 531 illustrates an odds adjustment module, according to an embodiment.

FIG. 532 illustrates an odds adjustment database, according to an embodiment.

FIG. 528 is a system for calculating and storing the odds data on a first wagering network and adjusting odds on a second wagering network based on the odds data from the first wagering network. This system may include a live event 52802, for example, a sporting event such as a football, basketball, baseball, or hockey game, tennis match, golf tournament, eSports, or digital game, etc. The live event 52802 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 52802, such as the score of an American football game or the run line in a baseball game, or a series of actions in the live event 52802. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 52802 or at another location.

Further, embodiments may include a plurality of sensors 52804 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 52804 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 52806 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 52806 may be communicatively coupled to a 1st wagering network 52814, which may perform real-time analysis on the type of play and the result of the play. The cloud 52806 may also be synchronized with game situational data such as the time of the game, the score, location on the field, weather conditions, and the like, which may affect the choice of play utilized. For example, in an exemplary embodiment, the cloud 52806 may not receive data gathered from the sensors 52804 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 52808 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 52808 could be an optional component and would be utilized in a situation where a paired wearable device employs the mobile device 52808 for additional memory or computing power or connection to the internet.

Further, embodiments may include a wagering software application or a wagering app 52810, which is a program that enables the user to place bets on individual plays in the live event 52802, streams audio and video from the live event 52802, and features the available wagers from the live event 52802 on the mobile device 52808. The wagering app 52810 allows the user to interact with the 1st wagering network 52814 to place bets and provide payment/receive funds based on wager outcomes.

Further, embodiments may include a mobile device database 52812 that may store some or all the user's data, the live event 52802, or the user's interaction with the 1st wagering network 52814.

Further, embodiments may include the 1st wagering network 52814, which may perform real-time analysis on the type of play and the result of a play or action. The 1st wagering network 52814 (or the cloud 52806) may also be synchronized with game situational data, such as the time of the game, the score, location on the field, weather conditions, and the like, which may affect the choice of play utilized. For example, in an exemplary embodiment, the 1st wagering network 52814 may not receive data gathered from the sensors 52804 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The 1st wagering network 52814 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a 1st user database 52816, which may contain data relevant to all users of the 1st wagering network 52814 and may include, but is not limited to, a user ID, a device identifier, a paired device identifier, wagering history, or wallet information for the user. The 1st user database 52816 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the 1st user database 52816 may contain betting lines and search queries. The 1st user database 52816 may be searched based on a search criterion received from the user. Each betting line may include but is not limited to, a plurality of betting attributes such as at least one of the following: the live event 52802, a team, a player, an amount of wager, etc. The 1st user database 52816 may include, but is not limited to, information related to all the users involved in the live event 52802. In one exemplary embodiment, the 1st user database 52816 may include information for generating a user authenticity report and a wagering verification report. Further, the 1st user database 52816 may be used to store user statistics like, but not limited to, the retention period for a particular user, frequency of wagers placed by a particular user, the average amount of wager placed by each user, etc.

Further, embodiments may include a 1st historical plays database 52818 that may contain play data for the type of sport being played in the live event 52802. For example, in American Football, for optimal odds calculation, the historical play data may include metadata about the historical plays, such as time, location, weather, previous plays, opponent, physiological data, etc.

Further, embodiments may utilize a 1st odds database 52820 that may contain the odds calculated by a 1st odds calculation module 52822 to display the odds on the user's mobile device 52808 and take bets from the user through the mobile device wagering app 52810.

Further, embodiments may include the 1st odds calculation module 52822, which utilizes historical play data to calculate odds for in-play wagers.

Further, embodiments may include an odds information module 52824, which may begin with the odds information module 52824 connecting to the 2nd wagering network 52826. First, the odds information module 52824 may continuously poll for a request from the odds collection module 52836 for the odds data stored in the odds database 52820. The odds information module 52824 may receive a request from the odds collection module 52836 for the odds data stored in the 1st odds database 52820. Next, the odds information module 52824 may extract the odds data stored in the 1st odds database 52820. For example, the data extracted from the odds database 52820 may be the number of wagers placed on the previous wager market, such as 1,500 wagers, the amount of money wagered on the previous wager market, such as $25,000 wagered, how many users wagered on the previous wager market, such as 800 users wagered on the previous wager market. The odds information module 52824 may send the extracted data from the 1st odds database 52820 to the odds collection module 52836, and the process may return to continuously poll for a request from the odds collection module 52836.

Further, embodiments may include the 2nd wagering network 52826, which may perform real-time analysis on the type of play and the result of a play or action. The 2nd wagering network 52826 (or the cloud 52806) may also be synchronized with game situational data, such as the time of the game, the score, location on the field, weather conditions, and the like, which may affect the choice of play utilized. For example, in an exemplary embodiment, the 2nd wagering network 52826 may not receive data gathered from the sensors 52804 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. In addition, the 2nd wagering network 52826 can offer several software as a service (SaaS) managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a 2nd user database 52828, which may contain data relevant to all users of the 2nd wagering network 52826 and may include, but is not limited to, a user ID, a device identifier, a paired device identifier, wagering history, or wallet information for the user. The 2nd user database 52828 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the 2nd user database 52828 may contain betting lines and search queries. The 2nd user database 52828 may be searched based on a search criterion received from the user. Each betting line may include, but is not limited to, a plurality of betting attributes such as at least one live event 528102, team, player, amount of wager, etc. The 2nd user database 52828 may include but is not limited to information related to all the users involved in the live event 52802. In one exemplary embodiment, the 2nd user database 52828 may include information for generating a user authenticity report and a wagering verification report. Further, the 2nd user database 52828 may be used to store user statistics like, but not limited to, the retention period for a particular user, frequency of wagers placed by a particular user, the average amount of wager placed by each user, etc.

Further, embodiments may include a 2nd historical plays database 52830 that may contain play data for the type of sport being played in the live event 52802. For example, in American Football, for optimal odds calculation, the historical play data may include metadata about the historical plays, such as time, location, weather, previous plays, opponent, physiological data, etc. Further, embodiments may utilize a 2nd odds database 52832 that may contain the odds calculated by a 2nd odds calculation module 52834 to display the odds on the mobile device 52808 of the user and take bets from the user through the mobile device wagering app 52810.

Further, embodiments may include the 2nd odds calculation module 52834, which may utilize historical play data to calculate odds for in-play wagers.

Further, embodiments may include an odds collection module 52836, which may begin with the odds collection module 52836 connecting to the 1st wager network 52814. The odds collection module 52836 may send a request for the odds data to the odds information module 52824. Thus, the odds collection module 52836 may continuously poll for the odds data from the odds information module 52824. The odds collection module 52836 may receive the odds data from the odds information module 52824. For example, the data received may be the number of wagers placed on the previous wager market, such as 1,500 wagers, the amount of money wagered on the previous wager market, such as $25,000 wagered, how many users wagered on the previous wager market, such as 800 users that wagered on the previous wager market. The odds collection module 52836 may initiate the odds adjustment module 52838.

Further, embodiments may include an odds adjustment module 52838, which may begin with the odds adjustment module 52838 initiated by the odds collection module 52836. The odds adjustment module 52838 may compare the received odds data with the odds adjustment database 52840. For example, the received odds data may be, 1,500 wagers with $25,000 wagered, and 800 users that wagered on the previous wager market. This data may be compared to the odds adjustment database 52840, which may exceed a predetermined threshold of over 1,000 wagers placed on the previous wager market and over 500 users placing wagers on the previous wager market. The odds adjustment module 52838 may determine if the received odds data meets any thresholds stored in the odds adjustment database 52840. For example, the received odds data may be, 1,500 wagers with $25,000 wagered on the previous wager market, and 800 users that wagered on the previous wager market. This data may be compared to the odds adjustment database 52840, which may exceed a predetermined threshold of over 1,000 wagers placed on the previous wager market and over 500 users placing wagers on the previous wager market. If the received odds data meets any of the thresholds stored in the odds adjustment database 52840, then the odds adjustment module 52838 may extract the corresponding action. For example, since the received odds data exceeded the threshold of over 1,000 wagers placed on the previous wager market, then the action may be to decrease the current or next wager market available odds by 10% to provide more even odds for the users. The odds adjustment module 52838 may then extract data from the odds adjustment database 52840, such as “10% Decrease. Data.” The odds adjustment module 52838 may execute the extracted action for the wager odds on the next available wager market. For example, the data in the odds adjustment database 52840 may be extracted and executed, such as “10% Decrease. Data,” which may be a program or software leveraged to identify the next available wager market and decrease the odds by 10%. For example, if the next wager market contained odds in the Boston Red Sox vs. New York Yankees, that the first pitch would be a strike at 2:1 odds, these odds may decrease by 10% to 1.8:1. If the received odds data do not meet any of the thresholds stored in the odds adjustment database 52840 or after the extracted action is executed by the odds adjustment module 52838, then the process may end.

Further, embodiments may include an odds adjustment database 52840. The odds adjustment database 52840 may contain the thresholds which may be compared to the received odds data, the action if the threshold is exceeded or not, and the data file that may contain an executable program to act. The odds adjustment database 52840 may be used in the process described in the odds adjustment module 52838, wherein the received odds data may be compared to the data stored in the odds adjustment database 52840. In some embodiments, thresholds may be for different wager markets, such as from one wager in a play-by-play wagering system to another wager. Further still, the thresholds may be for different live events 52802 of the same sport or different sports. In addition, in some embodiments, the actions may increase, decrease, or stay the same based on the number of wagers placed on the previous wagering market, how much money was wagered on the previous wagering market, how many users wagered on the previous wagering market, how many views the wagering market received or how many users looked at the wagering market on their device, how many clicks a wagering market received, etc.

FIG. 529 illustrates the odds information module 52824. The process may begin with the odds information module 52824 connecting, at step 52900, to the 2nd wager network 52826. Next, the odds information module 52824 may continuously poll, at step 52902, for a request from the odds collection module 52836 for the odds data stored in the odds database 52820. The odds information module 52824 may receive, at step 52904, a request from the odds collection module 52836 for the odds data stored in the odds database 52820. Next, the odds information module 52824 may extract, at step 52906, the odds data stored in the odds database 52820. For example, the data extracted from the odds database 52820 may be the number of wagers placed on the previous wager market, how much money was wagered on the previous wager market, how many users wagered on the previous wager market, such as there were 1,500 wagers on the previous wager market, there was $25,000 wagered on the previous wager market, and there were 800 users that wagered on the previous wager market. The odds information module 52824 may send, at step 52908, the extracted data from the odds database 52820 to the odds collection module 52836, and the process may return to step 52902 to continuously poll for a request from the odds collection module 52836.

FIG. 530 illustrates the odds collection module 52836. The process may begin with the odds collection module 52836 connecting, at step 53000, to the 1st wager network 52814. The odds collection module 52836 may send, at step 53002, a request for the odds data to the odds information module 52824. Next, the odds collection module 52836 may continuously poll, at step 53004, for the odds data from the odds information module 52824. The odds collection module 52836 may receive, at step 53006, the odds data from the odds information module 52824. For example, the data received may be the number of wagers placed on the previous wager market, how much money was wagered on the previous wager market, how many users wagered on the previous wager market, such as there were 1,500 wagers on the previous wager market, there was $25,000 wagered on the previous wager market, and there were 800 users that wagered on the previous wager market. The odds collection module 52836 may initiate, at step 53008, the odds adjustment module 52838.

FIG. 531 illustrates the odds adjustment module 52838. The process may begin with the odds adjustment module 52838 being initiated, at step 53100, by the odds collection module 52836. The odds adjustment module 52838 may compare, at step 53102, the received odds data to the odds adjustment database 52840. For example, if the received odds data were 1,500 wagers with $25,000 wagered, and 800 users that wagered on the previous wager market, this data may be compared to the odds adjustment database 52840, which may exceed the threshold of over 1,000 wagers placed on the previous wager market and over 500 users placing wagers on the previous wager market. The odds adjustment module 52838 may determine, at step 53104, if the received odds data meets any of the thresholds stored in the odds adjustment database 52840. For example, if the received odds data were 1,500 wagers with $25,000 wagered, and 800 users that wagered on the previous wager market, this data may be compared to the odds adjustment database 52840, which may exceed the threshold of over 1,000 wagers placed on the previous wager market and over 500 users placing wagers on the previous wager market. If the received odds data meets any of the thresholds stored in the odds adjustment database 52840, then the odds adjustment module 52838 may extract, at step 53106, the corresponding action. Continuing with the prior example, since the received odds data exceeded the threshold of over 1,000 wagers placed on the previous wager market, then the action may be to decrease the current or next wager market available odds by 10% to provide more even odds for the users. The odds adjustment module 52838 may extract the data from the odds adjustment database 52840, such as “10% Decrease. Data.” The odds adjustment module 52838 may execute, at step 53108, the extracted action for the wager odds on the next available wager market. For example, the data in the odds adjustment database 52840 may be extracted and executed, such as “10% Decrease. Data,” which may be a program or software utilized to identify the next available wager market and decrease the odds 10%. For example, if the next wager market contained odds in the game between the Boston Red Sox vs. New York Yankees, the odds that the first pitch would be a strike at 2:1 odds, these odds may decrease by 10% 1.8:1. If the received odds data does not meet any of the thresholds stored in the odds adjustment database 52840 or after the extracted action is executed by the odds adjustment module 52838, then the process may end at step 53110.

FIG. 532 illustrates the odds adjustment database 52840. The database may contain the thresholds in which the received odds data is compared, the action if the threshold is exceeded or is not reached, and the data file that may contain an executable program to act. This database may be used in the process described in the odds adjustment module 52838, wherein received odds data may be compared to the data stored in the odds adjustment database 52840. In some embodiments, the thresholds may be for different wager markets, such as from one wager in play-by-play wagering system to another wager, the thresholds may be for different live events 52802 of the same sport or different sports. In addition, in some embodiments, the actions may increase, decrease, or stay the same based on the number of wagers placed on the previous wager market, how much money was wagered on the previous wagering market, how many users wagered on the previous wagering market, how many views the wagering market received or how many users looked at the wagering market on their device, how many clicks a wagering market received, etc.

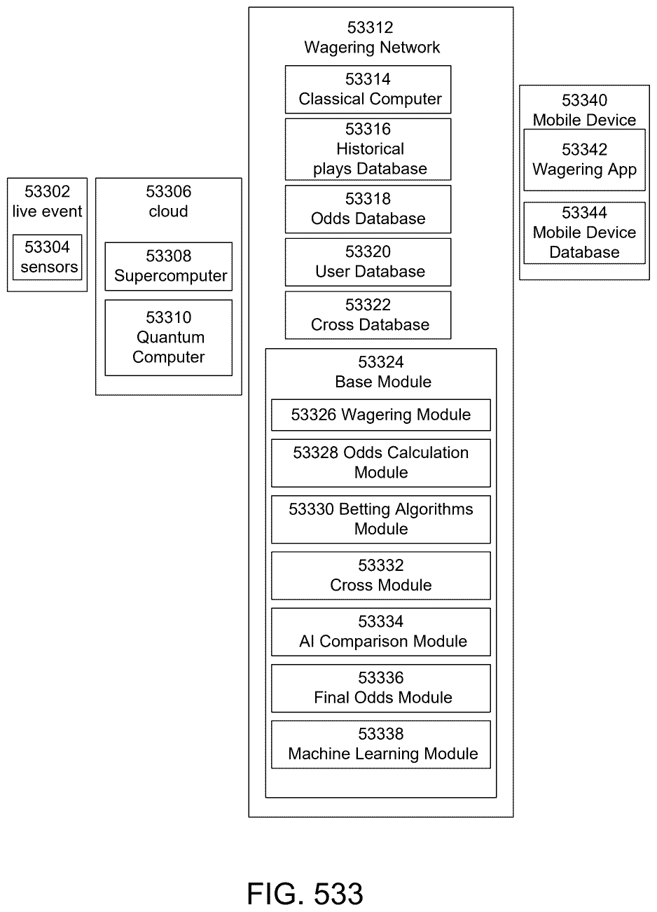

FIG. 533 Illustrates a system for a quantum sports betting algorithms engine, according to an embodiment.

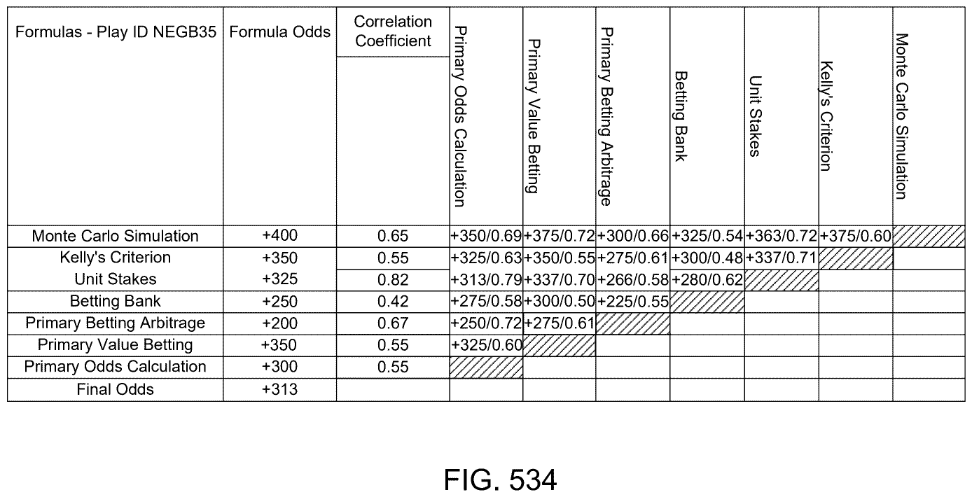

FIG. 534 Illustrates a cross-database, according to an embodiment.

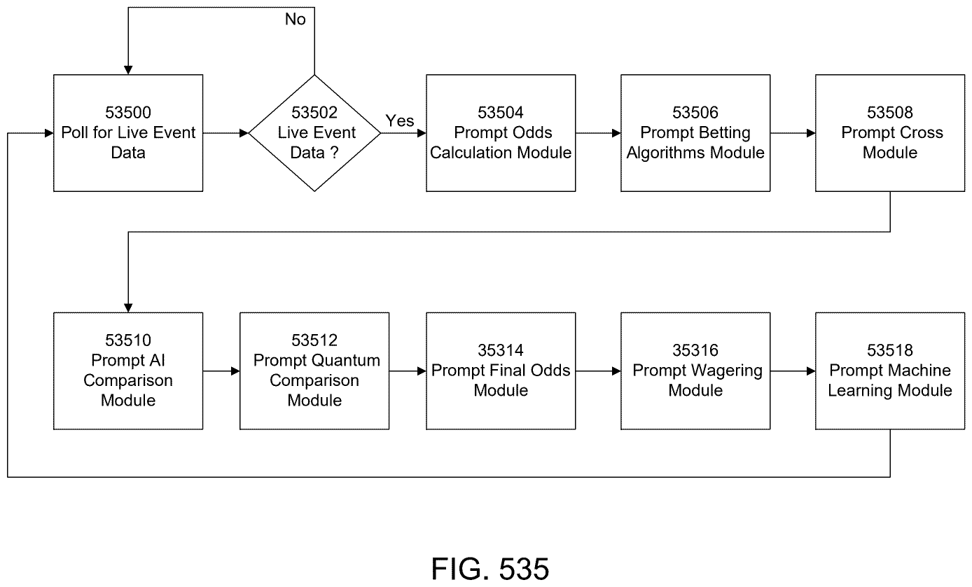

FIG. 535 Illustrates a base module, according to an embodiment.

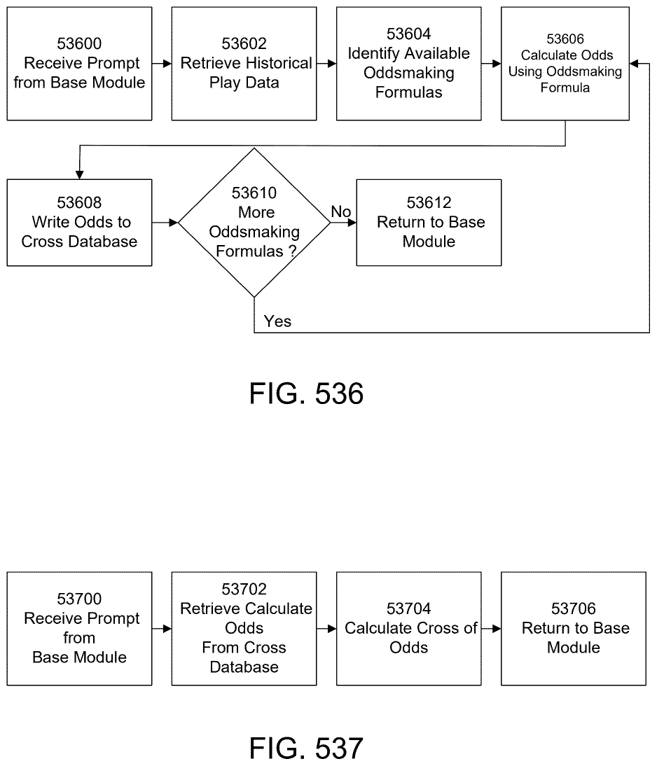

FIG. 536 Illustrates a betting algorithms module, according to an embodiment.

FIG. 537 Illustrates a cross-module, according to an embodiment.

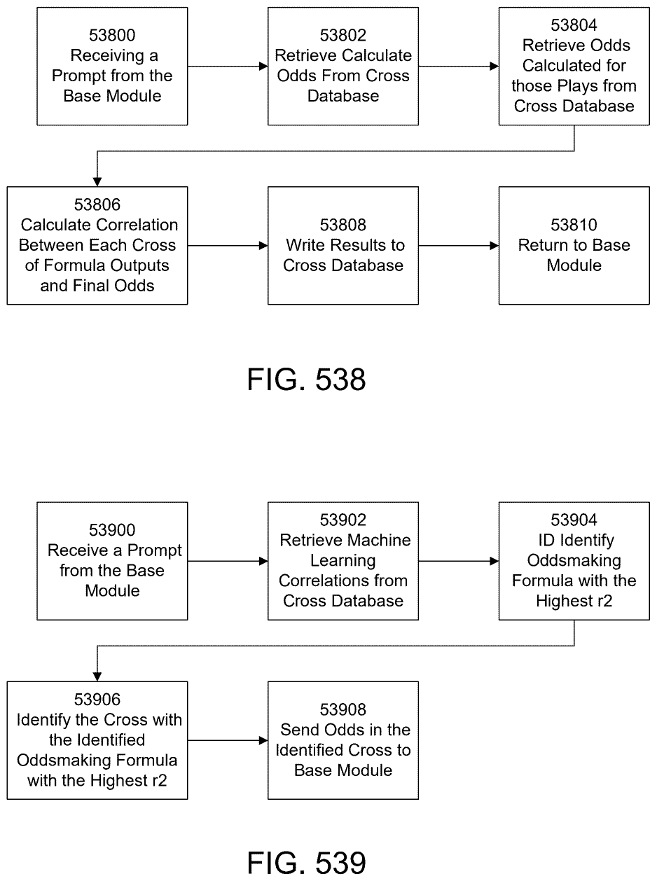

FIG. 538 Illustrates an AI comparison module, according to an embodiment.

FIG. 539 Illustrates a final odds module, according to an embodiment.

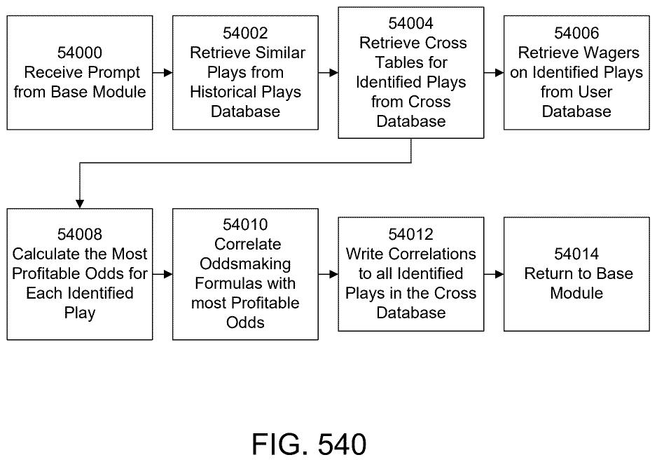

FIG. 540 Illustrates machine learning, according to an embodiment.

FIG. 533 is a system for a quantum sports betting algorithms engine. This system may include a live event 53302, for example, a sporting event such as a football, basketball, baseball, or hockey game, tennis match, golf tournament, eSports, or digital game, etc. The live event 53302 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 53302, such as the score of an American football game or the run line in a baseball game, or a series of actions in the live event 53302. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 53302 or at another location

Further, embodiments may include a plurality of sensors 53304 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 53304 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 53306 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economics of scale, like a public utility. In contrast, third-party clouds allow organizations to focus on their core businesses instead of expending resources on computer infrastructure and maintenance. The cloud 53306 may be communicatively coupled to a peer-to-peer wagering network 53312, which may perform real-time analysis on the type of play and the result of the play. The cloud 53306 may also be synchronized with game situational data such as the time of the game, the score, location on the field, weather conditions, and the like, which may affect the choice of play utilized. For example, in an exemplary embodiment, the cloud 53306 may not receive data gathered from the sensors 53304 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a supercomputer 53308, a computer with a high-performance level compared to a general-purpose computer. Supercomputer performance is commonly measured in floating-point operations per second (FLOPS) instead of million instructions per second (MIPS). In 2017, for instance, supercomputers can perform over 1017 FLOPS (a hundred quadrillion FLOPS, 100 petaFLOPS, or 100 PFLOPS). Supercomputers play an essential role in the field of computational science. Supercomputers may be used for a wide range of computationally intensive tasks in various areas. These include quantum mechanics, weather forecasting, climate research, oil and gas exploration, molecular modeling (computing the structures and properties of chemical compounds, biological macromolecules, polymers, and crystals), and physical simulations (such as simulations of the early moments of the universe, airplane and spacecraft aerodynamics, the detonation of nuclear weapons, and nuclear fusion).

Further, embodiments may include a Quantum computer 53310, which may use the quantum phenomena such as superposition and entanglement to perform computation. Computers that perform quantum computations are known as quantum computers. Quantum computers may solve certain computational problems, such as integer factorization (which underlies RSA encryption), substantially faster than classical computers. Examples of several quantum computers (or rather, quantum computing systems), may include the quantum circuit model, quantum Turing machine, adiabatic quantum computer, one-way quantum computer, and various quantum cellular automata. The most widely used model is the quantum circuit. Quantum circuits are based on the quantum bit, or “qubit,” which is somewhat analogous to the bit in classical computation. Qubits can be in a 1 or 0 quantum state, or they can be in a superposition of the 1 and 0 states. However, when qubits are measured, the measurement results are always either a 0 or a 1; the probabilities of these two outcomes depend on the quantum state that the qubits were in immediately before the measurement. A quantum computer may also solve any computational problem that a classical computer can solve. Conversely, any problem that a quantum computer can solve can also be solved by a classical computer, at least in principle, given enough time.

Further, embodiments may include a wagering network 53312, which may perform real-time analysis on the type of play and the result of a play or action. The wagering network 53312 (or cloud 53306) may also be synchronized with game situational data, such as the game's time, the score, location on the field, weather conditions, and the like, affecting the choice of play utilized. For example, in other exemplary embodiments, a wagering network 53312 may not receive data gathered from sensors and may, instead, receive data from an alternative data feed, such as SportsRadar®. This data may be provided substantially immediately following the completion of any play, and the data from this feed may be compared with a variety of team data and league data based on a variety of elements, including down, possession, score, time, team, and so forth, as described in various exemplary embodiments herein. The wagering network can offer several software as a service managed services such as user interface service, risk management service, compliance, pricing and trading service, IT support of the technology platform, business applications, game configuration, state-based integration, fantasy sports connection, integration to allow the joining of social media, as well as marketing support services that can deliver engaging promotions to the user.

Further, embodiments may include a classical computer 53314 machine that may automatically carry out sequences of arithmetic or logical operations via computer programming. Classical computer 53314 can follow generalized sets of functions, called programs. These programs enable computers to perform a vast range of tasks. A “complete” classical computer including the hardware, the operating system (main software), and peripheral equipment required and used for “full” operation can be referred to as a computer system. This term may also be used for a group of connected computers and work together, particularly a computer network or computer cluster. Classical computer 53314 may be used as control systems for a wide variety of industrial and consumer devices. This includes simple special-purpose devices like microwave ovens and remote controls, factory devices such as industrial robots and computer-aided design, and general-purpose devices like personal computers and mobile devices such as smartphones. The Internet is run on computers, and it connects hundreds of millions of other computers and their users. Conventionally, a classical computer 53314 includes at least one processing element, typically a central processing unit (CPU) in the form of a microprocessor, along with some computer memory, typically semiconductor memory chips. The processing element carries out arithmetic and logical operations, and a sequencing and control unit can change the order of operations in response to stored information. Peripheral devices include input devices (keyboards, mice, joystick, etc.), output devices (monitor screens, printers, etc.), and input/output devices that perform both functions (e.g., the 2000s-era touchscreen). Peripheral devices allow information to be retrieved from an external source, and they enable the result of operations to be saved and retrieved.

Further, embodiments may include a historical play database 53316 containing play data for the type of sport being played in the live event 53302. For example, in American Football, for optimal odds calculation, the historical play data should include metadata about the historical plays, such as time, location, weather, previous plays, opponent, physiological data, etc.

Further, embodiments may utilize an odds database 53318 that may contain the odds calculated by the odds calculation module 53328 and the multipliers for distance and path deviation and may be used for reference by the wagering module 53326 to take bets from the user through a user interface and calculate the payouts to the user.

Further, embodiments may utilize a user database 53320, which may contain data relevant to all system users, which may include, a user ID, a device identifier, a paired device identifier, wagering history, and wallet information for each user.

Further, embodiments may include a cross-database 53322, which may contain the output of the betting algorithms module 53330, the output of the cross-module 53332, the output of the AI comparison module 53334, and the output of the final odds module 53336. The machine learning module 53338 and the mechanisms of the odds-making formulas may be used by the betting algorithms module 53330 for all previous plays that have offered wagers on at least one outcome on the wagering network 53312.

Further, embodiments may include a base module 53324 that may control the order of operations of the other modules and databases on the wagering network 53312 and enable the flow of information about the live event 53302 from either the sensors 53304, the cloud 53306, or some combination of those. The base module 53324 may also enable the interaction of the wagering app 53342 on the mobile device 53340.

Further, embodiments may include a wagering module 53326 that may present available wagers from the wagering network 53312 to users of the wagering app 53342, collect their wagers, compare the wagers to the actual results, and utilize the odds to adjust the user's account balance in the user database 53320. Further, the wagering module 53326 may allow the user to place wagers on individual plays inside the live event 53302 through the wagering app 53342. Once a wager is placed, the live event 53302 may be monitored for the end of the play, in this example, the referee's whistle in an American football game. The actual play result may be compared to the wager. The play result, wager, wager amount, and odds may then be used to calculate the adjustment to the user's wallet information in the user database 53320. The wagering app 53342 may be monitored for more wagers until the user logs off or the live event 53302.

Further, embodiments may include an odds calculation module 53328, which may utilize historical play data to calculate odds for in-play wagers. The information from the historical plays database 53316 may include data related to the type of the play, the previous information related to players involved in the live event 53302, and results of the previous live events 53302. The odds for each live event 53302, such as in a baseball game, a particular player hitting a home run, a single, or a strikeout, may be calculated based on the information received from the sensors 53304 and the previous information related to the particular player. Further, the odds may be updated based on in-game events (for example, a player strikes a home run with the same pitcher, decreasing his odds of getting a strikeout from the same pitcher). The odds may be calculated or adjusted based on statistical information related to the live event 53302 and the players' statistical information. For example, the odds may be determined based on the historical data such as prior performance information about a player (like batting average against a certain pitcher, earned run average, catch probability, hamstring strain), and physiological information of player(s), etc., and current, i.e., real-time information, such as current confidence level, etc. In one exemplary embodiment, the type of wagering may be depending on the type of game being played. In one exemplary embodiment, the odds calculation module 53328 may determine the available wagers to the user. The odds calculation module 53328 may also comprise a probability engine, which may assemble all the historical data and real-time data and produce the odds (stored in the odds database 53318) for in-play wagers. Thus, the odds calculation module 53328 may provide useful information on all the potential outcomes, as available wagers, which may facilitate the user with a better knowledge to make certain judgments about the potential performance of players in each live event 53302 and place a calculated wager with a potential return on the wager. For example, in a baseball game, the odds calculation module 53328 may calculate odds related to Aaron Judge of New York Yankees, playing 3rd innings against the Clayton Kershaw of LA dodgers, hitting a single is 4/1 (for example, in money line +200), hitting a double are 5/1, hitting a home run are 3/1, and a strikeout is 2/1. Further, a money line of +200 would mean that the user would profit from $200 if the user places a wager of $100 and the user stands correct.

Further, embodiments may include a betting algorithms module 53330 that may calculate the odds on at least one possible outcome of a play inside the live event 53302, using at least one additional odds-making formula than the one used by the odds calculation module 53328.

Further, embodiments may include a cross module 53332 that may calculate at least one combination of the odds created by the different odds making formulas in the betting algorithms module 53330.

Further, embodiments may include an AI comparison module 53334 that may calculate the correlation between each cross of odds making formulas in the cross database 53322, as calculated by the cross module 53332, and the final odds on each of the identified similar plays. In this example, a trendline is plotted using the final odds on all identified similar plays. The odds calculated by crossing each odds making formula may then be compared to that trendline.

Further, embodiments may include a final odds module 53336 that may identify the odds making formula with the highest correlation to the most profitable odds for similar plays and then may identify the cross of that odds making formula's odds with another odds making formula to offer the best possible odds through the wagering module 53326.

Further, embodiments may include a machine learning module 53338 that may compare the actual results of plays in the live event 53302 with the odds created by each odds-making formula and the crosses between those formulas to identify the most profitable odds the wagering network 53312. The profitability of each of the odds-making formula odds may be compared to the most profitable odds calculated to identify the odds-making formula most highly correlated with the most profitable odds for similar plays.

Further, embodiments may include a mobile device 53340 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple iPhone. Some devices allow gesture recognition inputs by combining some of the inputs and outputs. Some devices allow for facial recognition, which may be utilized as an input for different purposes, including authentication and other commands. Some devices provide voice recognition and inputs, including, e.g., Microsoft KINECT, SIRI for iPhone by Apple, Google Now, or Google Voice Search. Additional user devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality, including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or a wall, and may also interact with other electronic devices. Some I/O devices, display devices, or groups of devices may be augmented reality devices. An I/O controller may control the I/O devices. The I/O controller may control one or more I/O devices, such as e.g., a keyboard and a pointing device, e.g., a mouse or optical pen. Furthermore, an I/O device may also contain storage and an installation medium for the computing device. In still other embodiments, the computing device may include USB connections (not shown) to receive handheld USB storage devices. In further embodiments, an I/O device may be a bridge between the system bus and an external communication bus, e.g., a USB bus, a SCSI bus, a FireWire bus, and an Ethernet, a Gigabit Ethernet bus, a Fiber Channel bus, or a Thunderbolt bus. In some embodiments, the mobile device 53340 could be an optional component. It would be utilized in a situation in which a paired wearable device utilizes the mobile device 53340 as additional memory or computing power or connection to the Internet.

Further, embodiments may include a wagering app 53342 which may be a program that enables the user to place bets on individual plays in the live event 53302 and may display the audio and video from the live event 53302 as well as the available wagers on the mobile device 53340. The wagering app 53342 allows the user to interact with the wagering network 53312 to place bets and provide payment/receive funds based on wager outcomes.

Further, embodiments may include a mobile device database 53344 that may store user data, historical play data, primary odds, data, etc.

FIG. 534 illustrates the cross-database 53322. FIG. 534 illustrates the cross-database 53322. The cross-database 53322 may contain the output of the betting algorithms module 53330, the cross-module 53332, the AI comparison module, the final odds module 53336, the machine learning module 53338, and the odds-making formulas used by the betting algorithms module 53330. The wagering network 53312 may use several odds-making formulas. In this example, the wagering network 53312 is using seven odds making formulas: the primary odds calculation output from the odds calculation module 53328 based on the information available in the historical plays database 53316, a primary value betting formula, a primary betting arbitrage formula, a betting bank formula, a unit stakes formula, Kelly's criterion formula, and a Monte Carlo simulation. Formulas could be, for example, formulas that are in and of themselves computer program modules designed to find profitable sports betting opportunities. They may use vast amounts of data from past sporting matches to identify patterns, which can then calculate the probability of certain sporting outcomes. In most cases, primary betting algorithms may calculate the probability of various outcomes and compare those probabilities to bookmakers' odds to identify bets that are worth placing. Primary betting algorithms can be divided into two types, depending on what they aim to achieve: value betting formulas and betting arbitrage formulas. Primary value betting formulas are used on any bet where the odds for a certain outcome seem favorable, based on the probability of that outcome occurring. There are plenty of value betting formulas that collect data from past sporting matches, estimate the probability of various outcomes. There are two parts to a value betting formulas. First, the formula needs to identify value bets, which relates to the idea of expected value. Second, the formula needs to suggest an appropriately sized bet, depending on how confident the bet could be made. Finding value bets is all about finding bets with an expected value greater than the bet's stake. The expected value of a bet is the profit or loss you can expect to make when placing a bet over and over again. With a value bet, the odds provided are high enough that a profit should be made based on the estimation of the outcome's probability. To calculate the expected value of a bet- and thus identify value bets-betting formulas rely on past data. By looking at how often a certain outcome occurred in past matches and analyzing the matches' trends, formulas may predict what will happen in an upcoming match. For example, if a football team scores an average of 2.1 goals every game, you can expect them to score more than two goals in an upcoming match. Primary betting arbitrage formulas may be used when an advantage is sought for changing odds for certain sporting outcomes. For example, a primary betting arbitrage formula may be used when one uses “betting exchanges,” where betters can place a bet at favorable odds and then place a bet against their original bet (thereby guaranteeing a profit) once the odds have moved. This algorithm, the primary betting arbitrage, may be used when “patterns in odds” can be determined. Many professional betters like to have a set betting bank (size varies depending on wealth) from which they place all their bets. This allows them to easily keep track of profit and loss because all winnings and losses are coming from the same bank. It also allows them to stake set proportions of their bank on bets, which reflect their confidence in the selection's chances. Profit from the bank is periodically withdrawn when it reaches a certain amount for non-betting purposes. For example, a user may have a betting bank of 1000 dollars, from which the user may withdraw profit every time the bank reaches 1500 dollars or instead whatever profit has been made each three months. Formulas such as this may look at the user database 53320 change the odds if the user has large quantities of money in the bank vs. small quantities money. Assigning unit stakes to bets may be useful as it may further discipline the bettor to be less likely to over bet in an event. Sometimes a maximum and minimum unit stake may be used, from one unit to twenty units. Depending on the punter's seriousness, a unit may be $1, $10, $100, or even more. These units are usually referred to as points. The more disciplined, the bettor, the smaller band of units they may use. This may make them less likely to over or under bet an outcome, as the confidence difference between units will be even more clearly defined in their minds. For example, a user may have stakes varying from 1 to 5 points. Each point may be worth 20 dollars. A minimum bet for a user may be 20 dollars, and a maximum bet may be 100 dollars. Formulas such as this may look at the user database 53320 and adjust the odds if the user has larger unit stakes vs. less range of unit stakes. Kelly's Criterion is a formula that may be used to determine how much of a bank should be risked on a given bet. The formula may consider the bet's odds, the probability that it will win, and the probability that it will lose. This may ensure the whole bank is never lost on a bet and may steadily increase the bank. A disadvantage of this may be that there is no way of guaranteeing that money won't be lost. There may be a ⅓ chance of halving the bankroll before it is doubled. A Monte Carlo simulation (MCS) is also known as a system used by punters to forecast a wager's outcome. Working as a model of chance, the system may use a computer algorithm to run simulations to obtain a wager's probability. This may be done by converting uncertainties into probability by simulating a model numerous times to get a firm conclusion. An MCS may input the variables of a model into probability distributions and randomly select from them, essentially working similarly to the crowd's wisdom where the more one guesses, the closer to the result the system may be. For example, using the Monte Carlo method to determine whether the Patriots will win in a game versus the Giants. The system may add various parameters to the system, all of which could influence the game's result. For example, weather, head-to-head form, injuries, and starting quarterback could all impact. The system can then allow the function and system to run its course and produce a more accurate probability of the Patriots winning. The betting algorithms module 53330 may run some or all of the available betting formulas for each possible outcome of an available wager to populate the formula odds column of the cross-database 53322. In this example, the table may contain data related to the 35th play of an American football game between the New England Patriots and the Green Bay Packers being a run. In this example, the odds returned by the odds calculation module 53328 based on the historical play database 53316 may be +300 on the run. In this example, the MCS may have returned odds of +400 on the same play resulting in a run. Each available formula may be crossed against each other formula by the cross-module 53332 to create blended odds. Those odds may be blended by taking the mid-point between the two odds. The odds may also be weighted towards one or the other or mixed in some other fashion. In this example, the cross between the primary odds calculation odd of +300 and the MCS odds of +400 may be +350. The AI comparison module 53334 may populate each cross cell with a correlation coefficient relating each cross of odds to being correct in the context of this play. In this example, the cross between the primary betting arbitrage odds formula of +200 and the primary value betting formula of +350 may have a correlation coefficient of 0.61 with the final odds in similar historical plays. Similar plays may be defined differently based on characteristics of the play, game, players involved, weather, etc. In this example, similar plays are defined as having the same down and distance to go in the same quarter of a game. Finally, the machine learning module 53338 may compare the final odds to the actual result and the odds produced by each odds making formula.

FIG. 535 illustrates the base module 53324. The process may begin with polling, at step 53500, the cloud 53306, or the sensors 53304, for new data related to the live event 53302. If there is not live event data, the module may return from step 53502 to step 53500 and continue to poll for new data. If there is data from the live event 53302, the module may prompt, at step 53504, the odds calculation module 53328. As described earlier, the odds may be calculated or adjusted based on statistical information related to the live event 53302 and the players' statistical information. For example, the odds may be determined based on the historical data such as prior performance information about a player (like batting average against a particular pitcher, earned run average, catch probability, hamstring strain), and physiological information of player(s), etc., and current, i.e., real-time information, such as current confidence level, etc. In one exemplary embodiment, the type of wagering may be depending on the kind of game being played. In one exemplary embodiment, the odds calculation module 53328 may determine the available wagers to the user. The odds calculation module 53328 may also comprise a probability engine, which may assemble all the historical data and real-time data and produce the odds (stored in the odds database 53318) for in-play wagers. Thus, the odds calculation module 53328 may provide useful information on all the potential outcomes, as available wagers, which may facilitate the user with a better knowledge to make individual judgments about the possible performance of players in each live event 53302 and place a calculated wager with a potential return on the wager. For example, in a baseball game, the odds calculation module 53328 may calculate odds related to Aaron Judge of New York Yankees, playing 3rd innings against the Clayton Kershaw of LA dodgers, hitting a single is 4/1 (for example, in money line +200), hitting a double are 5/1, hitting a home run are 3/1, and a strikeout is 2/1. Further, a money line of +200 may mean that the user would profit from $200 if the user places a wager of $100 and the user stands correct. The base module 53324 may prompt, at step 53506, the betting algorithms module 53330, which may calculate odds on the next play in the live event 53302 using at least two different odds making formulas, such as Primary Odds Calculation, Primary Value Betting, Primary Betting Arbitrage, Betting Bank Unit Stakes or Kelly's Criterion or Monte Carlo Simulation. The base module 53324 may prompt, at step 53508, the cross-module 53332 to blend the results of each of the odds making formulas used by the odds calculation module 53328. The base module 53324 may prompt, at step 53510, the AI comparison module 53334 to calculate the correlation between each cross odds making formulas and the final odds in a similar play. Once the basic odds are calculated and the AI comparisons have been completed between all odds, the odds could be calculated. However, at this step, the historical plays database 53316 may be evaluated to see how much data and choices for a given play there are and to see if a quantum model could best serve the odds calculations. For instance, classical computers that work through probabilities can determine probabilities by analyzing the number of possibilities. For example, if there are three possibilities, then 2 to the power of 3 or 8 unique combinations. If each possibility is a zero or one, then 2 to the 3rd power has eight unique numbers. So, for instance, in a play-by-playing bet, for a batter up at baseball, odds could be calculated based on the next play being (1) a swing or not, (2) a ball if a swing, or (3) a hit if a swing. The choices are related to each other. That is, a swing could yield a ball or hit but is limited to that. So, the real decisions are (1) not swing, (2) swing and ball, and (3) swing and hit. In the first embodiment, there may only be three possibilities and three unique outcomes. In other possibilities, there could be several possibilities for the outcome. For instance, a strike could be any sub-event for not swinging (inside corner, outside corner, down the middle or for a swinging sub-event (swing check, complete swing, bunt-miss), etc. As the number of possibilities grows and sub-events within the possibility grow, the total number of possibilities increases. This may be further enhanced (made worse) if the probabilities and sub-events are concatenated. For example, a simple calculation shown in table 1 may calculate the odds for an entire game.

TABLE 1
Calculation of a total ODDs per Game

| | | | | | |
|---|---|---|---|---|---|
| [symbol] plays per game | 100 | 100 | 100 | 100 | 50 |
| outcomes per play | 20 | 10 | 10 | 5 | 5 |
| Outcomes per game | [symbol] | [symbol] | [symbol] | [symbol] | [symbol] |
| Number Odds per second | [symbol] | [symbol] | [symbol] | [symbol] | [symbol] |
| Seconds to game odds | [symbol] | [symbol] | [symbol] | [symbol] | [symbol] |
| Years to game odds | 4.0197E+116 | 3.17E+86 | 3.171E+84 | 2.5E+54 | 2.8164E+18 |

| seconds | minutes | hours | days | years | | |
|---|---|---|---|---|---|---|
| 1 | 60 | 60 | 24 | 365 | [symbol] | seconds per year |

CONCLUSION
50 plays per game
5 different outcomes per play
1 billion Odds calculated per second (1 ns)
Will take [symbol] to the 17th years to [symbol] [symbol]
indicates data missing or illegible when filed

So, even for the fastest supercomputers, this is not a tenable result. At any point in time, by choosing any series of play-by-play odds to calculate, if, as in table 1, the time in seconds to calculate the game odds on a supercomputer should be less than the time between plays, so that the odds can be calculated and bet upon. This analysis is the foundational trigger to determine when a classical computer 53314, supercomputer 53308, and quantum computer 53310 should be used. Once these seconds are calculated based upon the # of plays and outcomes per play, the calculation for odds should be redirected to the appropriate computer (classical 53314, supercomputer 53308 or quantum computer 53310). It should be noted that the computations may be done on the cloud for the supercomputer or the quantum computer, and the classical computer 53314 (servers) are likely located within the wagering network 53312.

In the next embodiment, the computer may be chosen based upon speed and on the cost of using the computer. If it is possible to choose between any computer as the meet the speed requirements, the method may calculate the cost for expected use, and that cost will determine where to redirect the computation.

In the next embodiment, the computers may use offline (not in a real game) to determine the accuracy or range of the odds calculations. For a given scenario, such as, say, ten plays in a row, with 20 outcomes per play (as shown in Table 1), each computer for several scenarios may be run. The odds may be analyzed to see which computer has created the most profitable odds. This information may be used in a real game as if a scenario is offered for a series of play-by-play bets. The type of computer may be chosen based upon the most profitable and most enticing set of odds. For instance, if a quantum computer 53310 is used in a scenario where the profit is higher for the house, the quantum computer 53310 may be chosen over the supercomputer 53308 or classical computer 53314, even though the quantum computer would be more expensive to use. In this embodiment, the computer use cost may be calculated against the profit to be made at the best profit. If the net profit is larger after adding the computer costs, that computer may be chosen to run the real-time scenario.

In another embodiment, if the odds that are calculated appear to be below an expected profit limit while using the classical computer 53314, running the odds calculation module 53328, which may use the best-case cross found in running the cross-module 53332, a more sophisticated computer (supercomputer 53308 or quantum computer 53310) may be used. Suppose the more sophisticated computer's net profit is larger after adding the computer costs, that more sophisticated computer may be chosen to run the real-time scenario.

In that case, a quantum computer 53310 may be used (because of its ability to run many operations more quickly) to investigate several plays by play scenarios, such as numerous scenarios of say ten plays in a row, with 20 outcomes per play (as shown in Table 1), the quantum computer 53310 operation may define the best play-by-play scenario based upon both excitements of the game player and the profit to the house. To keep a game player playing, it is useful to change the scenarios based on the game's events.

In another embodiment, if a scenario of several plays and outcomes and odds to be offered by a classical computer has a probability of profit lower than a set amount, a more sophisticated computer may be executed to see if the profit can be improved. In this way, the house's profit may be routinely scrutinized to determine the best computer type for the best profit. In another embodiment, based upon the sports game and the sports game's progress, the entire game of all possibilities may be virtually played on a quantum computer 53310, to determine outcomes. If there is enough time to make final predictions of the game at best profitability, the sports game's ending could be bet on with the right odds during a play-by-play bet.

In another embodiment, a more sophisticated computer may be run in parallel (at random intervals) with the computer type being used, thereby double checking the best profitability. If it appears switching to the more sophisticated computer is more net profitable, then the more sophisticated computer may be used. The base module 53324 may prompt, at step 53512, the AI comparison module 53334. The base module 53324 then may prompt, at step 53514, the final odds module 53336 to select the odds from the cross-database 53322 or the AI comparison module 53334, to offer through the wagering module 53326. The base module 53324 then may prompt, at step 53516, the wagering module 53326 and may provide the final odds selected by the final odds module 53336. The module then may prompt, at step 53518, the machine learning module 53338 to compare the final odds selected by the final odds module 53336 with the actual results. The same comparison may be made between the odds calculated by each other odds making formula and the actual result in similar plays. The base module 53324 then may return to step 53500 polling for live event data.

FIG. 536 illustrates the betting algorithms module 53330. The process may begin with receiving, at step 53600, a prompt from the base module 53324 that there is a play in the live event 53302 that wagers may be placed upon with at least one outcome. The betting algorithms module 53330 may retrieve, at step 53602, data from the historical play database 53316 needed by the odds-making formulas. It should be evident that data beyond historical play data may be used by one or more of the odds making formulas. This data could include data from the user database 53320 about the users and their wagering history, current account balances, etc. The data may also include 3rd party analytics or other information related to the live event 53302, wagers, or users. The betting algorithms module 53330 may identify, at step 53604, the odds making formulas in the cross-database 53322 that are available to calculate odds to offer on a play in the live event 53302. In this example, all of the formulas in the cross-database 53322 are used for each wagering option. Still, it should be evident that different odds making formulas could be used, or only a subset of the available formulas could be used. That subset could also change based on the context of the live event 53302 or other reasons, such as the current handle or amount of exposure of the wagering network 53312. The betting algorithms module 53330 may calculate, at step 53606, the odds on at least one outcome of a play in a live event 53302 using the first available odds making formula. The betting algorithms module 53330 may loop back to this step for each odds-making formula used to calculate the odds. The betting algorithms module 53330 may write, at step 53608, the calculated odds to the cross-database 53322. The betting algorithms module 53330 may determine, at step 53610, if there are more odds-making formulas available in the cross-database 53322 that have not yet been used to calculate the odds on at least one outcome of a play in the live event 53302. If there are more odds making formulas available, the betting algorithms module 53330 may return to step 53606. If there are no more odds making formulas that are to be used at this time, the betting algorithms module 53330 may return, at step 53612, to the base module 53324.

FIG. 537 illustrates the cross-module 53332. The process may begin with the cross-module 53332 receiving, at step 53700, a prompt from the base module 53324 that odds have been calculated using at least two odds making formulas by the betting algorithms module 53330. The cross-module 53332 may then retrieve, at step 53702, the odds calculated by the betting algorithms module 53330 from the cross-database 53322. The cross-module 53332 may calculate, at step 53704, the cross between each set of calculated odds. In this example, the odds may be calculated by the primary value betting formula +350 on the New England Patriots to run on the 35th play of their game against the Green Bay Packers. The MCS may have calculated odds of +400 on the same play. The cross between these two odds may be calculated as +375. While the mid-point between the two odds may be used as the cross in this example. It should be evident that there are different ways to calculate the cross between the two odds. One of the two could be weighted more heavily than the other. The lower odds or higher odds could be favored by default. The odds closer to the primary odds calculation could be favored, or different variations of crossing the odds. This may be done for each set of odds created against every other set of odds created. When all of the crosses between each set of calculated odds have been calculated and written to the cross-database 53322, the module then may return, at step 53706, to the base module 53324.

FIG. 538 illustrates the AI comparison module 53334. The process may begin with the AI comparison module 53334 receiving, at step 53800, a prompt from the base module 53324 that there is a play in the live event 53302 that wagers may be placed upon at least one outcome. The AI comparison module 53334 may retrieve, at step 53802, plays similar to the current play that odds are being calculated for, from the historical plays database 53316. Similar plays can be defined in many different ways. In this example, a similar play is a play with the same down and distance to go in the same half. It should be obvious that a similar play can be defined in other ways, such as with an equal score, or other plays involving the same offense or the same defense, based on the stadium the game is played in, the current weather, the score of the game, or in several other ways. The AI comparison module 53334 may retrieve, at step 53804, the odds calculated by the available odds making formulas for the identified similar plays from the cross database 53322. The odds created by crossing the odds created by each odds making formula may also be retrieved from the cross database 53322. The AI comparison module 53334 may calculate, at step 53806, the correlation between each cross of odds making formulas in the cross-database 53322, as calculated by the cross-module 53332, and the final odds on each of the identified similar plays. In this example, a trendline is plotted using the final odds on all recognized similar plays. The odds calculated by crossing each odds making formula may then be compared to that trendline. If the odds for a particular cross of odds making formulas exactly matched the final odds on all previous plays, the correlation between that cross of odds-making formulas and the final odds may be an r-squared value of 1.0. The more significant the difference between the two data sets, the closer to zero the r-squared value becomes, indicating a lower correlation. This is done to identify the cross of odds making formulas that are most correlated with the final odds in the current context. In this example, the cross between the betting bank formula and Kelly's criterion formula has the lowest correlation to the final odds for similar plays, with an r-squared value of 0.48. The cross between the unit stakes odds and the primary odds calculation has the highest correlation to the final odds with an r-squared value of 0.79. While correlation may be used in this example, it should be obvious that other types of comparisons can be made, such as convolution, regression, etc. The AI comparison module 53334 may write, at step 53808, the calculated correlation coefficients to the cross-database 53322. The AI comparison module 53334 may return, at step 53810, to the base module 53324.

FIG. 539 illustrates the final odds module 53336. The process may begin with the final odds module 53336 receiving, at step 53900, a prompt from the base module 53324 that there is a play in the live event 53302 that wagers may be placed upon at least one outcome. The final odds module 53336 may retrieve, at step 53902, the output of the machine learning module 53338 on the similar historical plays for each of the odds making formulas from the cross database 53322. The final odds module 53336 may identify, at step 53904, the odds making formula with the highest r-squared value, indicating that it is the odds making formulas whose previous results are the most highly correlated with the actual results of the identified similar previous plays. In this example, the odds returned by the unit stakes formula were the most highly correlated to the actual results of plays identical to the current play, as represented by the r-squared value of 0.82. This may be calculated by the machine learning module 53338, which may examine the final odds offered on the wagering network 53312 and the odds of some or all of the available odds making formulas on all previous plays similar to the current play. The final odds module 53336 may identify, at step 53906, the cross with the identified odds making formula that has the highest correlation who's previous results are the most highly correlated to the final odds, as indicated by the r-squared value that is calculated by the AI comparison module 53334. In this example, the unit stakes formula was identified at step 53904, and the cross with the unit stakes formula that has the highest r-squared value is the primary odds calculations, with an r-squared of 0.79. This cross has odds of +350 on the run on the next play. The final odds module 53336 may send, at step 53908, the odds identified, to the base module 53324.

FIG. 540 illustrates the machine learning module 53338. The process may begin with the machine learning module 53338 receiving, at step 54000, a prompt from the base module 53324 that there is a play in the live event 53302 that wagers have been placed upon at least one outcome. The machine learning module 53338 may retrieve, at step 54002, the similar plays used by the AI comparison module 53334 from the historical plays database 53316. The machine learning module 53338 may retrieve, at step 54004, the cross tables for the plays identified at step 54002 from the cross database 53322. The machine learning module 53338 may retrieve, at step 54006, the wagers placed on the identified plays from the user database 53320. The machine learning module 53338 may calculate, at step 54008, the odds that would produce the most profit, or least loss, for the wagering network 53312 based on the amount wagered on that play. This may be done by using the amount of money wagered on a given outcome, the actual outcome, and the odds produced by each of the odds making formulas in the betting algorithms module 53330. It should be obvious that additional variables may be considered, such as the impact of the different odds on the action that is placed on a given outcome. The machine learning module 53338 may calculate, at step 54010, the correlation between the odds created by each odds making formula and the most profitable odds for each of the identified historical plays that are similar to the play that was just wagered on through the wagering module 53326. The correlation coefficient, represented as an r-squared value between zero and one, between each odds-making formula's profitability. In this example, the primary value betting formula was less correlated with the most profitable odds, with an r-squared value of 0.55, than the unit stakes formula, which had an r-squared value of 0.82 when correlated with the most profitable odds on all identified similar plays in the historical plays database 53316. The machine learning module 53338 may write, at step 54012, the correlation, expressed as an r-squared value in this example, to the table for each identified similar play in the cross database 53322. It should be obvious that there are other ways in which machine learning or AI can be applied to the historical performance of odds in a given context. For example, instead of the odds that would create the most profit for the wagering network 53312, the correlation could be to the odds that created the greatest handle or the largest number of wagers. The machine learning module 53338 may return, at step 54014, to the base module 53324.

The functions performed in the processes and methods may be implemented in differing order. Furthermore, the outlined steps and operations are only provided as examples. Some of the steps and operations may be optional, combined into fewer steps and operations, or expanded into additional steps and operations without detracting from the disclosed embodiments' essence.

### Abstract

A system involving analytics and collecting sensor data in real time. This system allows players to predict and wager on players actions during the course of a play that has yet to occur by collecting sensor data on the players to create a historical database. Utilizing an algorithm, the wagering odds may be provided to the users of the platform to place wagers on the upcoming play betting on the player's sensor data that is collected during the play. The algorithm may determine the probability of the outcome of the player's sensor data and these probabilities of the outcome allow users to determine if the player will exceed or not reach the potential outcome.

### EMBODIMENT 1B

### Wager Odds on Player Sensor Data

A system for live sporting event wagering, comprising: a plurality of sensors, a platform, and a user device, wherein the plurality of sensors capture sensor data from a live event, the platform receives and stores the captured data from the plurality of sensors data, filters a historical database containing data related to similar situations in the live event, and determines a most likely outcome associated with sensor data, and the probability of the most likely outcome is sent to the user device to receive a wager.

A betting exchange system for live sporting event wagering, comprising: a plurality of sensors, a platform, and a user exchange device, that allows multiple users to do exchange wagering, wherein the plurality of sensors capture sensor data from a live event, the platform receives and stores the captured data from the plurality of sensors data, filters a historical database containing data related to similar situations in the live event, and determines a most likely outcome associated with sensor data, and the probability of the most likely outcome is sent to the user exchange devices to allow them to have additional knowledge to improve their wagering.

For example, the sensors data of the live event may capture data of player injury via accelerometers in the players equipment. This injury data can be filtered from history to see if injury of that player occurred in the past and one can use the filters to determine if results changed. Using this change or results, the lay bettor may change the bet.

A machine learning betting system method for live sporting event wagering, comprising: a plurality of sensors, a platform, and a user device, wherein the plurality of sensors capture sensor data from a live event, the platform receives and stores the captured data from the plurality of sensors data, filters a historical database containing data related to similar situations in the live event, and determines a most likely outcome associated with sensor data, and the probability of the most likely outcome is determined by machine learning, then is sent to the user device to receive a wager.

For example, in a machine learning betting system method the sensors data of the live event may capture data of player injury via accelerometers in the players equipment. This injury data can be used to request a supervised learning module (previously supervised and trained on injury) to create new adjusted odds for the current play.

### EMBODIMENT 2A

### Wager Odds on Player Sensor Data

The embodiments generally relate to play-by-play sports wagering through mobile and wearable devices, and, in particular, to wagering done on a sporting event that the user is attending.

A method, system, and apparatus for wagering using a wearable device. In one embodiment, a wagering game system can include a historical play database from which the frequency of each event outcome in the historical play database can be filtered for an in-game context of each event; and a wearable device comprising a wearable device user interface and at least one sensor that captures in-game information, wherein the at least one sensor on the wearable device captures in-game data to determine a situation and context of a given event, and a calculation of odds for a variety of outcomes for a next event based upon historical play data and a presentation of the odds as potential wagers on the wearable device user interface.

Another embodiment relates to a method for wagering on a live event, including capturing data from a live event on one or more sensors of a wearable device; determining if the captured data exceeds a threshold value; calculating odds for a next event if the captured data exceeds a threshold value; displaying a wagering option for a next event on the wearable device; and accepting an input on the wearable device for a wager.

A system for providing play by play wagering to a user who is physically at a sporting event. The user has a wearable device that is used to capture game data, a local program calculates the odds of different event outcomes in the game based on observed game play and situation. The user can place their wager through the wearable device interface. The sensors on the wearable device, such as camera or microphone, are used to determine if the user won or lost their wager.

### EMBODIMENT 2B

A wagering game system comprising: a historical play database from which the frequency of each event outcome in the historical play database can be filtered for an in-game context of each event; and a wearable device comprising a wearable device user interface and at least one sensor that captures in-game information, wherein the at least one sensor on the wearable device captures in-game data to determine a situation and context of a given event, and a calculation of odds for a variety of outcomes for a next event based upon historical play data and a presentation of the odds as potential wagers on the wearable device user interface.

A betting exchange wagering system comprising: a historical play database from which the frequency of each event outcome in the historical play database can be filtered for an in-game context of each event; and a wearable device comprising a wearable device user interface and at least one sensor that captures in-game information, wherein the at least one sensor on the wearable device captures in-game data to determine a situation and context of a given event, and allowing a lay bettor to place a bet for a variety of outcomes for a next event based upon historical play data.

For example, in a betting exchange system method, the wearable device could capture information about the excitement of a layer (accelerometer changes) and this data is used to adjust the display to the lay bettor user of the exchange, since a 3rd party API could be used to get the lay bettor user data and show the lay bettor a user interface dedicated to a more excited layer, that is the display might have more advertisement than normal, as excitement might drive choosing advertisement.

A machine learning betting system method comprising: a historical play database from which the frequency of each event outcome in the historical play database can be filtered for an in-game context of each event; and a wearable device comprising a wearable device user interface and at least one sensor that captures in-game information, wherein the at least one sensor on the wearable device captures in-game data to determine a situation and context of a given event, and a calculation of odds for a variety of outcomes for a next event based upon historical play data and a presentation of the odds as potential wagers on the wearable device user interface.

For example, in a machine learning betting system method, a play by play sports book would extract the user wearable device data such as excitement (accelerometer movement) and the machine learning, over time, would learn the betting behavior of the user to the wearable data and use this data to adjust the odds.

### EMBODIMENT 3A

### Personalized Wagering on Live Events

The embodiments generally relate to gambling, particularly live events such as sporting events.

A method of offering and displaying wagers to a user of a betting or wagering game. The method can include selecting at least one bet to present to a bettor in a betting game, calculating baseline odds for the bet, adjusting the baseline odds for the bet based on user specific data, and presenting the bet with odds adjusted based on the user specific data to the user.

In another exemplary embodiment, a method of offering bets on a play in at a live event may include compiling a plurality of bets available to be offered in a betting game; calculating baseline odds for each of the plurality of bets; determining a knowledge level of a user of the betting game; and adjusting at least one of the availability of bets among the plurality of bets and the odds of bets among the plurality of bets based on the knowledge level of the user.

In another embodiment, a computer implemented method for providing bets on a play at a live event, executed by a processor, can include displaying a betting game interface; displaying one or more live events, the one or more live events capable of having wagers placed thereon; displaying one or more questions or prompts for information; and displaying one or more bets available to be made as a result to data collected and analyzed in response to the one or more questions or prompts for information.

A method for providing personalized bets to a user betting on plays during a live event by determining the user's level of knowledge about the live event via a series of questions or prompts on the user device, selecting one or more bets relevant to the live event from an eligible bet database matching the knowledge level of the user and determining the baseline odds of the bets based on historical data from a play history database. Further, collecting interactions by the user with the user device, storing the user interactions in the user interaction database and polling the user interaction database to determine a baseline level of engagement based on past live events and determining a relative level of engagement of the user with the user device at the current live event.

### EMBODIMENT 3B

A method of offering a bet on a play at a live event, comprising: selecting at least one bet to present to a bettor in a betting game, calculating baseline odds for the bet, adjusting the baseline odds for the bet based on user extracted data, and presenting the bet with odds adjusted based on the user data to the user.

A betting exchange system offering a bet on a sportsbook play at a live event, comprising: selecting at least one lay bet to present to a lay bettor in a betting game, calculating baseline odds for the bet, adjusting the baseline odds for the bet based on user extracted data, and presenting the bet with odds adjusted based on the user data to the user, and using these odds to inform an exchange betting system.

For example, in a betting exchange system method, once lay odds are placed in a sports book, the sports book could send these lay odds to a betting exchange, if the user approves.

A machine learning betting system offering a bet on a play at a live event, comprising: selecting at least one bet to present to a bettor in a betting game, calculating baseline odds for the bet, adjusting the baseline odds for the bet based on user extracted data, and presenting the bet with odds adjusted based on the user data to the user.

For example, a supervised machine learning betting system was trained to create the next odds for a bet based upon the example histories of bettors for various bets, so when the history of the bettor is known, the supervised machine learning system can create the adjusting the baseline odds for the bet based on user extracted data.

### EMBODIMENT 4A

### Advertising Via a Live Event Wagering Platform

The present disclosure is generally related to delivering advertisements, particularly via a wagering platform at a live event.

The embodiments relate to a method and system for providing content. One embodiment includes a method for delivering advertisements to a bettor who is wagering on a live event via a wagering platform, including providing plays during a live event sports game, receiving advertisement content to be displayed via the wagering platform, receiving at least one condition to be met before displaying the advertisement content, relating the at least one condition to be met to at least one advertisement content, using live event data to determine a play, upon the occurrence of a play, matching the at least one condition to be met and the associated advertisement content, and displaying the advertisement content to the bettor.

Another exemplary embodiment includes a method of displaying content, including accessing a wagering platform, displaying one or more live events on which wagers may be placed, displaying one or more wagers for a live event; displaying information about a play in the live event; displaying an advertisement that is related to one or more conditions associated with at least one of the live event and data from the wagering platform.

Another exemplary embodiment provides a system for providing and displaying content, that can include a user device; a live event; a content database; and a wagering platform, where the user device accesses the wagering platform and provides wagering capabilities and the wagering platform accesses the content database in response to at least one condition being met, the at least one condition being met comprising at least one of an occurrence in the live event, a wager placed on the user device through the wagering platform, a result of a wager placed on the user device placed through the wagering platform, and a location of the user device.

A wagering platform which matches data provided by an advertiser to situational data at a live event to deliver ads to a bettor by receiving data from an advertiser including advertisement content, conditions under which the advertisement should be delivered, and a schedule of live events during which the advertisement should be delivered to a bettor and saving the data to an advertisement database. The data in the advertisement database is compared against data from a live event, sensor and interaction data collected by a user device used by a bettor, and demographics and behavioral data relevant to the bettor can be used to identify an advertisement matching the present conditions, and further deliver the identified advertisement to the bettor.

### EMBODIMENT 4B

A method for delivering advertisements to a bettor who is wagering on a live event via a wagering platform, comprising: providing plays during a live event sports game, receiving advertisement content to be displayed via the wagering platform, receiving at least one condition to be met before displaying the advertisement content, relating the at least one condition to be met and at least one wagering condition on the wagering platform to be met to at least one advertisement content, using live event data to determine a play, upon the occurrence of a play, matching the at least one condition to be met and the associated advertisement content, and displaying the advertisement content to the bettor.

A betting exchange system method for delivering advertisements to a bettor who is wagering on a live event via a wagering betting exchange platform, comprising: providing plays during a live event sports game, receiving advertisement content to be displayed via the wagering platform, receiving at least one condition to be met before displaying the advertisement content, relating the at least one condition to be met and at least one wagering condition on the wagering platform to be met to at least one advertisement content, using live event data to determine a play, upon the occurrence of a play, matching the at least one condition to be met and the associated advertisement content, and displaying the advertisement content to the bettor.

For example, if the betting exchange system method of layer of the bet provides larger than normal odds, it may mean the layer of the bet is very sure of themselves, so that would be a condition to show an aggressive and larger advertisement, that is, if they are sure they are going to win, they may be more prone to answer a larger ad.

A machine learning betting system for delivering advertisements to a bettor who is wagering on a live event via a wagering platform, comprising: providing plays during a live event sports game, receiving advertisement content to be displayed via the wagering platform, receiving at least one condition to be met before displaying the advertisement content, relating the at least one condition to be met and at least one wagering condition on the wagering platform to be met to at least one advertisement content, using live event data to determine a play, upon the occurrence of a play, matching the at least one condition to be met and the associated advertisement content, and displaying the advertisement content to the bettor.

For example, in a machine learning betting system if an unsupervised machine learning system learns the best answered type ads from the historical data of events and users and odds, and upon finding a matching condition in the unsupervised machine learning system, allows the ad to be placed in a current bet for a current user.

### EMBODIMENT 5A

### Sensor Data Improving Wagering Odds

The embodiments are generally related to improving wagering odds offered by a wagering in-play sports gaming platform.

A system involving analytics and collecting sensor data in real time. This system allows players to predict and wager on players actions during the course of a play that has yet to occur by collecting sensor data on the players to create a historical database. Utilizing an algorithm, the wagering odds may be improved using the various sensor data collected using artificial intelligence or machine learning. The algorithm may determine the probability of the outcome of the play through player's sensor data and these probabilities of the outcome provide additional data for a wagering platform to provide improved wagering odds to its users.

### EMBODIMENT 5B

A wagering odds improvement system, comprising: a plurality of sensors, an in-play sports gaming platform, and a user device, wherein the plurality of sensors capture sensor data from a live event, and the in-play sports gaming platform receives and stores the sensor data, filters a historical sensor database on similar event data, determines if there is a correlation between the sensor data and the similar event data, determines a probability of the occurrence of a play, and updates wagering odds offered by the in-play sports gaming platform.

A betting exchange system odds improvement system, comprising: a plurality of sensors, an in-play sports betting exchange gaming platform, and a user device, wherein the plurality of sensors capture sensor data from a live event, and the in-play sports betting exchange gaming platform receives and stores the sensor data, filters a historical sensor database on similar event data, determines if there is a correlation between the sensor data and the similar event data, shows data to potential layers of the probability of the occurrence of a play, so that the bet layer may lay a new bet.

For example, in a betting exchange system method, if there is a correlation between the sensor data and the similar event data, shows data to potential layers of the probability of the occurrence of a play, so that the bet layer may lay a new bet. Also, the betting exchange system could provide the backer with data from the sensor captured data and correlations to events to help the backer take the bet.

A machine learning betting system, comprising: a plurality of sensors, an in-play sports gaming platform, and a user device, wherein the plurality of sensors capture sensor data from a live event, and the in-play sports gaming platform receives and stores the sensor data, using a machine learning system on historical sensor data on similar event data, and using machine learning, determines if there is a correlation between the sensor data and the similar event data, then using machine learning determines a probability of the occurrence of a play, and updates wagering odds offered by the in-play sports gaming platform.

For example, if a machine learning betting system has unsupervised machine learning system used over time showed a 10% reduction in completed pass plays in football when there is rain at the game (rain sensors) and the turf is soggy (wet sensor) then this unsupervised data is used in a similar event to adjust odds.

### EMBODIMENT 6A

### System for Concession, Merchandise, and Sponsored Wagers

The exemplary embodiments may be generally related to sports betting and smart phone applications.

A method for wagering through a graphical interface. The method may include identifying a macro event with more than one potential outcome, identifying a micro event with more than one potential outcome within the macro event, presenting betting options and odds to a user through a graphical user interface based on the more than one potential outcome of the micro event, allowing one or more sponsor to alter the betting options or odds, receiving bets on the altered betting options, receiving the outcome of the micro event, and crediting the bettor based on the outcome of the micro event and received bet if the bettor won the bet, with a monetary and/or a non-monetary reward.

An exemplary embodiment includes a data management and analytic statistical software system/wagering platform in which users can place wagers in order to win prizes from game day sponsors such as swag, merchandise, or items from the concessions. In addition, the sponsor can sweeten the deal on a bet by paying the “vig” or house take, improving the odds, matching an amount wagered, and the like. Advertisers may condition these improvements on viewing an ad or engaging with sponsored content. Deals between the sponsor and the offeror of the bet may take the form of affiliate advertising. Advertisers can show bettors how much more they made or how much less they had to wager due to the advertiser's influence. Swag or merchandise may also include coupons.

### EMBODIMENT 6B

A method for wagering on an action in real time, comprising: identifying a macro event with more than one potential outcome; identifying a micro event within the macro event, the micro event having more than one potential outcome; presenting betting options and odds based on the more than one potential outcome of the micro event; allowing one or more sponsors to alter at least one betting option; and receiving a bet wagered on the at least one altered betting option.

A betting exchange system method for wagering on an action in real time, comprising allowing a layer to lay odds on an event, allowing one or more sponsors to alter the odds; and receiving a backer on the altered odds of the event.

For example, if a betting exchange system method includes layer is placing a bet on a particular team at high odds, a sponsor, such as the team owners can add a prize (a concession at the next game) if the odds are accepted by a backer and the layer wins.

A machine learning betting system method for wagering on an action in real time, comprising: identifying a macro event with more than one potential outcome; identifying a micro event within the macro event, the micro event having more than one potential outcome; presenting betting options and odds based on the more than one potential outcome of the micro event; allowing machine learning to select from a list of one or more sponsors to alter at least one betting option; and receiving a bet wagered on the at least one altered betting option.

For example, a machine learning betting system method uses an unsupervised machine learning system learns over time that as the unsupervised learning system choses random sponsors from a list of sponsors for a particular event, and particular bet, where the better choses the sponsors alteration of a bet (for example adds a coupon), then the unsupervised machine learning over time produces a higher probability of success to the better of an event to choose a sponsor.

### EMBODIMENT 7A

### System for User Experience Based Odds Adjustment

An exemplary embodiment is generally related to sports betting and smart phone applications.

A method for adjusting odds of a sports betting game. The method may include the steps of: identifying an event and associated potential outcomes, identifying micro-events with more than one potential outcomes within the event, presenting betting options and odds to a user or bettor based on the potential outcomes of the micro-event, adjusting the odds presented to the user based on the user's past betting behavior, receiving a bet wagered on at least one betting option, and crediting the user if the user wins the bet.

An exemplary embodiment includes a method of cultivating and storing user profiles based on a user's betting trends and demographic information and predicting rewards accordingly through the use of artificial intelligence (AI), where the user places bets through a proprietary data management and analytic software system/wagering platform. For example, the AI may suggest that a twenty-one-year-old male user who just won a large wager also receives a reward of a beer coupon. An embodiment may include a set of proprietary algorithms used to assess betting odds of users of different experience levels (i.e., an algorithm for beginner users and an algorithm for experienced users), where the users are subscribers of a proprietary data management and analytic software system/wagering platform. In this embodiment, the algorithms vary depending on the experience level of the user.

An exemplary embodiment further includes a proprietary method of creating custom odds for individuals based upon a person's respective betting history, where bets were made via a proprietary data management and analytic software system/wagering platform. An embodiment includes a method of extracting and incorporating user feedback into a data management and analytic software system/wagering platform in order to create and improve upon specific odds which may then be sent as notifications to the user as wagers of potential interest. An embodiment includes a method of assessing a user's betting history to predict a user's future behavior with respect to future wagers or purchases made through advertisements, where the user is a subscriber of a proprietary data management and analytic software system/wagering platform. An embodiment includes a method of providing the results of sports wagers made by specific users of a sports analysis and betting platform to those users, including the user's in-game history (right vs. wrong), the winners of previous drives/quarters, the amount of points or money the user has won, the occurrence of a significant play, such as a touchdown, etc.

An embodiment may include a software system designed for sports analytics and data management with respect to wagering on events in real time, where the software system is capable of assessing a user's level of sports or sport knowledge by a series of algorithms dependent on user data, such as frequency of placing a wager, sports wagered on, teams wagered on, amount of money wagered. For example, if the user is consistently placing wagers and then does not place a wager for 2+ months, the algorithms can lower the users experience levels since they have not been actively wagering for a long period of time and are not as experienced as they were 2+ months ago.

### EMBODIMENT 7B

A method for sports game betting using a determined level of sport or sports knowledge comprising: identifying an event with more than one potential outcome at a conclusion of the event; identifying a micro-event within the event, the micro event having more than one potential outcome at its conclusion but not dependent on the conclusion of the event; presenting betting options and odds to through a graphical user interface based on the more than one potential outcome of the micro event; and adjusting the odds based on a betting behavior corresponding to the bettor.

A betting exchange system method for sports game betting using a determined level of sport or sports knowledge comprising: identifying an event with more than one potential outcome at a conclusion of the event; identifying a micro-event within the event, the micro event having more than one potential outcome at its conclusion but not dependent on the conclusion of the event; allowing a “layer bettor” to create odds through a graphical user interface based on the more than one potential outcome of the micro event; and providing to the “layer bettor” feedback on their odds based upon the previous betting behavior corresponding to the “layer better”.

For example, in a betting exchange system method, for an event that has a particular player in a micro event the “layer better” places 2:1 odds betting $10 dollars, the past history of that “layer bettor” for a event like the particular player in a micro event shows the “layer better” had never bet on this player and micro event, the feedback could be “warning, this is the first time you have placed a bet on this player and this type of the event”.

A machine learning betting system method for sports game betting using a determined level of sport or sports knowledge comprising: identifying an event with more than one potential outcome at a conclusion of the event; identifying a micro-event within the event, the micro event having more than one potential outcome at its conclusion but not dependent on the conclusion of the event; calculating using a supervised machine learning algorithm, betting options and odds and then presenting betting options and odds to through a graphical user interface based on the more than one potential outcome of the micro event; and adjusting the odds based on a betting behavior corresponding to the bettor.

For example, in a machine learning betting system method the supervised machine learning algorithm is trained to correlate micro events and betting results of particular bettors establish a supervised machine learning bettor behavior pattern. This bettor behavior pattern is correlated with the current bettor behavior pattern when establishing betting options.

### EMBODIMENT 8A

### Improving Odds Based on Physiological Data

The embodiments are generally related to improving wagering odds for a wagering platform.

The embodiments include methods, systems, and apparatuses for generating wagering odds using physiological data. One embodiment includes a system for creating wagering odds, which can include a single play sports gaming platform that receives and stores physiological data from a plurality of sensors associated with one or more participants in a live event and similar event data from a historical database, wherein the single play sports gaming platform further filters the similar event data from the historical database, determines if there is a correlation between the physiological data and the similar event data, determines a potential result of an action, and determines wagering odds offered by the single play sports gaming platform.

Another exemplary embodiment includes a computer implemented method for providing a game program using game information, including executing on a processor the steps of displaying a wagering platform; displaying one or more live events on which wagers may be placed; displaying indicia that indicates physiological sensor data is captured in the one or more live events; displaying one or more real time wagers for a live event; displaying information about a play in the live event; and displaying results of a wager from the one or more real time wagers.

A system involving analytics and collecting physiological data in real time. This system allows users to predict and wager on players actions during the course of a play that has yet to occur by collecting physiological data on the players to create a historical database. Utilizing an algorithm, the wagering odds may be improved using the various physiological data collected using artificial intelligence or machine learning. The algorithm may determine the outcome of the play through player's physiological data and these potential outcomes provide additional data for a wagering platform to provide improved wagering odds to its users.

### EMBODIMENT 8B

A system for creating wagering odds, comprising: a single play sports gaming platform that receives and stores physiological data from a plurality of sensors associated with one or more participants in a live event and similar event data from a historical database, wherein the single play sports gaming platform further filters the similar event data from the historical database, determines if there is a correlation between the physiological data and the similar event data, determines a potential result of an action, and determines wagering odds offered by the single play sports gaming platform.

A betting exchange system for creating wagering odds, comprising: a single play sports gaming platform that receives and stores physiological data from a plurality of sensors associated with one or more participants in a live event and similar event data from a historical database, wherein the single play sports gaming platform further filters the similar event data from the historical database, determines if there is a correlation between the physiological data and the similar event data, determines a potential result of an action, and provides to a “layer bettor” these determined wagering odds offered by the single play sports gaming platform, wherein the layer bettor can change their odds if desired based upon this determined wagering odds.

For example, a betting exchange system method is trained to recognize correlations between physiological data such as player activity (movement) and performance on certain plays and this performance data can be used to adjust lay odds (if the football player is tired thru lots of activity in the gain beyond “normal” the supervised learning system will create “low performance” and this would be a threshold to lower the odds on that play achieving a particular success (a completed pass in football).

A machine learning betting system for creating wagering odds, comprising: a single play sports gaming platform that receives and stores physiological data from a plurality of sensors associated with one or more participants in a live event and similar event data from a historical database, wherein the single play sports gaming platform further filters the similar event data from the historical database, determines if there is a correlation between the physiological data and the similar event data, determines by a supervised machine learning algorithm a potential result of an action, and determines wagering odds offered by the single play sports gaming platform.

For example, a supervised learning betting system machine is trained to recognize correlations between physiological data such as player activity (movement) and performance on certain plays and this performance data can be used to adjust odds (if the football player is tired thru lots of activity in the gain beyond “normal” the supervised learning system will create “low performance” and this would be a threshold to lower the odds on that play achieving a particular success (a completed pass in football).

### EMBODIMENT 9A

### Artificial Intelligence/Machine Learning Enhanced Betting Odds

The embodiments are generally related to sports wagering and artificial intelligence.

Embodiments may describe methods, systems, and apparatuses for providing and adjusting wagers on individual game events in real time and further may provide for accurate odds for such wagers. One embodiment includes a method for generating and adjusting odds, including receiving statistical information from a game play data source and of a non-gameplay data source based upon changes at a live sporting event related to the a live sporting event in real time, storing the results of an action in the live event in a database, filtering the historic database on situational data that matches upcoming action in the live sporting event based upon changes at the live event related to the non-gameplay data source, performing correlations on similar historical data, determining the difference of the correlated data, comparing the difference to a recommendations database, and adjusting wager odds based on the recommendations database.

Another embodiment includes a computer implemented method for providing odds adjustment during a live event, including executing on a processor the steps of displaying a sports wagering platform; displaying a live event on which wagers can be made; displaying non-gameplay data; displaying adjusted odds for one or more predictions for a future play, the adjusted odds based on a comparison of situational data in the live event, non-gameplay data related to the live event, and historical data; and displaying one or more wagers placed on the adjusted odds.

A software system capable of utilizing artificial intelligence and/or machine learning to produce sports analytics based on historical score data for specific teams, players, events, or other relevant data. In the embodiments, machine learning can be applied to the historical data in order to improve the betting odds. Correlations between event outcomes and available parameters can be analyzed in advance and in real time by an “Odds Module” to give accurate and up-to-date odds.

### EMBODIMENT 9B

A method for generating and adjusting odds, comprising: receiving statistical information from a game play data source and of a non-gameplay data source based upon changes at a live sporting event related to a live sporting event in real time, storing the results of an action in the live event in a database, filtering the historic database on situational data that matches upcoming action in the live sporting event based upon changes at the live event related to the non-gameplay data source, performing correlations on similar historical data, determining the difference of the correlated data, comparing the difference to a recommendations database, and adjusting wager odds based on the recommendations database.

A betting exchange system method for generating and adjusting odds, comprising: receiving statistical information from a game play data source and of a non-gameplay data source based upon changes at a live sporting event related to a live sporting event in real time, storing the results of an action in the live event in a database, filtering the historic database on situational data that matches upcoming action in the live sporting event based upon changes at the live event related to the non-gameplay data source, performing correlations on similar historical data, determining the difference of the correlated data, comparing the difference to a recommendations database, and showing a “layer bettor” who just place a bet, the correlated data to allow the “layer bettor” to adjust their odds based upon the adjusting wager odds based on the recommendations database.

For example, if a betting exchange system method, non-game data like snow during a football game negatively impacts long passes being completed, the betting exchange system will find this correlation and adjust the lay odds of a long pass accordingly.

A machine learning system method for generating and adjusting odds, comprising: receiving statistical information from a game play data source and of a non-gameplay data source based upon changes at a live sporting event related to a live sporting event in real time, storing the results of an action in the live event in a database, using a using a supervised machine learning system on a historic database on situational data that allows the supervised learning database to match upcoming action in the live sporting event based upon changes at the live event related to the non-gameplay data source, performing correlations on similar historical data, determining the difference of the correlated data, comparing the difference to a recommendations database, and adjusting wager odds based on the recommendations database.

For example, in a machine learning betting system method, if non-game data like snow during a football game negatively impacts long passes being completed, the supervised learning system will find this correlation and adjust the odds of a long pass accordingly.

### EMBODIMENT 10A

### Real Time Action of Interest Notification System

Embodiments are generally related to online betting platforms for single action wagering on sporting events.

The embodiments describe methods, systems and apparatuses for providing notifications. One embodiment provides a computer implemented method of alerting a user of a wager, including retrieving by a server, characteristics of a live action regarding a live event, comparing the live action characteristics to data in a historical database related to previous actions of a user, determining if any characteristics of the live action are highly correlated with one of the historical interest or a preselected option, applying at least one filter to wagering activity of a user based upon a second characteristic of the live action, determining if any two characteristics of the live action are highly correlated with the user's historical interest, and outputting on a display of the communication device a notification of the live action when it is correlated to the historical interest of the user.

Another embodiment provides a computer implemented method for providing notifications in a game program, including executing on a processor the steps of displaying at least one of a first real time event and data associated with the first real time event in a wagering game on a user device; displaying a notification that one or more wagers for wagering in a second real time event in a wagering game correlated to a historical interest of a user of a wagering game are available on the user device; displaying the one or more wagers in the real time event correlated to the historical interest of the user; displaying information about a play in the live event; and displaying results of a wager from the one or more real time wagers.

A method of identifying wagers trends from a user's wagering history in order to alert the user of similar wagers that are available. The user interacts with a betting platform which displays all of the live plays available to be wagered upon, and the odds of those wagers. The user's interaction with the application may be recorded, along with their wagering data and a plurality of play characteristics. As the betting platform receives a new live play available to be wagered on, it may compare the characteristics of the new play to the user's history and may notify the user of the new play if it is highly correlated with their past wagering interactions with the platform.

### EMBODIMENT 10B

A computer implemented method of alerting a user of a wager, comprising: retrieving by a server, characteristics of a live action regarding a live event, comparing the live action characteristics to data in a historical database related to previous actions of a user, determining if any characteristics of the live action are highly correlated with one of the historical interest or a preselected option, applying at least one filter to wagering activity of a user based upon a second characteristic of the live action, outputting on a display of the communication device a notification of the live action when it is correlated to the historical interest of the user and upon a determination that the user is one of viewing a second live event than the live event or interacting with data associated with the second live event.

A betting exchange system computer implemented method of alerting a user of a wager, comprising: retrieving by a server, characteristics of a live action regarding a live event, comparing the live action characteristics to data in a historical database related to previous actions of a user, determining if any characteristics of the live action are highly correlated with one of the historical interest or a preselected option, applying at least one filter to wagering activity of a user based upon a second characteristic of the live action, outputting on a display of the communication device a notification of the live action when it is correlated to the historical interest of the user and upon a determination that the user is one of viewing a second live event than the live event or interacting with data associated with the second live event and then alerting a user to come to the betting exchange system to bet (“lay betting or “backing betting”).

For example, in a betting exchange system method, if a first type of lay bettor has placed several bets on a favorite team and favorite players towards the end of a game, if the same situation exists on a current game, the betting exchange system alerts users that matches the first type of lay bettors.

A machine learning betting system computer implemented method of alerting a user of a wager, comprising: retrieving by a server, characteristics of a live action regarding a live event, comparing the live action characteristics to data in a historical database related to previous actions of a user, determining if any characteristics of the live action are highly correlated (using an unsupervised machine learning system) with one of the historical interest or a preselected option, applying at least one filter to wagering activity of a user based upon a second characteristic of the live action, outputting on a display of the communication device a notification of the live action when it is correlated to the historical interest of the user and upon a determination that the user is one of viewing a second live event than the live event or interacting with data associated with the second live event.

For example, in a machine learning betting system method, the unsupervised machine learning system learns over time that bets (with a group of bettors) on a favorite team and favorite players exists towards the end of a game, so if the same situation exists on a current game, the machine learning betting system alerts the same group of bettors for the opportunity to bet.

### EMBODIMENT 11A

### AI Wager Odds Adjuster

The embodiments are generally related to sports wagering and artificial intelligence.

The embodiments provide methods, systems, and apparatuses for adjusting wagers in a real time betting platform. One embodiment includes a method of adjusting wager odds that provides for filtering a historic database to match a current wager, selecting a common parameter within the historic data, performing correlations for the selected parameter against other parameters within the historic database, determining if there is correlated data, extracting data points from the correlated data, and comparing the extracted data points to a predetermined threshold, and adjusting a current wager if the extracted data exceeds the predetermined threshold.

Another exemplary embodiment provides a system for adjusting wagers, including a live event; a historic database that stores data related to one or more previous events; situational data in the live event; at least one module executed by a processor to compare one or more parameters associated with situational data received from the live event to related situational data in the historic database, determines if there is correlated data, and adjusts any wager placed on the situational data received from the live event based upon if the correlated data meets or excess a threshold; and a display which displays the adjusted odds.

A method of using artificial intelligence (AI) to assess and adjust the betting odds for live game wagers before they are presented to users based correlations between various parameters and user betting behavior, and to adjust the betting odds while the betting window is open based on how users are currently betting compared to expected user betting behavior.

### EMBODIMENT 11B

A method of adjusting wager odds, comprising: filtering a historic database to match a current wager; selecting a common parameter within the historic data; performing correlations for the selected parameter against other parameters within the historic database; determining if there is correlated data; extracting data points from the correlated data; comparing the extracted data points to a predetermined threshold; and adjusting a current wager if the extracted data exceeds the predetermined threshold.

A betting exchange system method of adjusting wager odds, comprising: filtering a historic database to match a current wager; selecting a common parameter within the historic data; performing correlations for the selected parameter against other parameters within the historic database; determining if there is correlated data; extracting data points from the correlated data; comparing the extracted data points to a predetermined threshold; and showing the results (of the current wager if the extracted data exceeds the predetermined threshold) to a layer better, allowing the layer better to change their odds on the next bet.

For example, if a betting exchange system method found that common parameters such as profit for a game player who lay bets for a player to be successful on a lay bet is high for a particular type of event (say a punt in football) for a particular player, the betting exchange system would provide that information to adjust the current lay wager, that is keep the odds conservative to minimize how much profit a game player can take.

A machine learning betting system method of adjusting wager odds, comprising: filtering a historic database to match a current wager; selecting a common parameter within the historic data; performing supervised machine learning to find correlations for the selected parameter against other parameters within the historic database; determining if there is correlated data; extracting data points from the correlated data; comparing the extracted data points to a predetermined threshold; and adjusting a current wager if the extracted data exceeds the predetermined threshold.

For example, if a machine learning betting system method, the supervised machine learning found that common parameters such as profit for a game player who bets for a player to be successful on a bet is high for a particular type of event (say a punt in football) for a particular player, the machine learning system would provide that information to adjust the current wager, that is keep the odds conservative to minimize how much profit a game player can take.

### EMBODIMENT 12A

### Community Based Event Driven Wagering Platform

The embodiments are generally related to wagering on individual events inside of a sporting event. The use of mobile devices to facilitate event based wagering, and how the multitude of users of mobile event driven wagering platform interact with one another.

A community-based gaming method may be provided. The method may include calculating odds of events within a live sporting event, communicating the odds as available wagers to a user, receiving selected wagers, monitoring event results, and calculating the user's balance based on the event results and the selected wagers. The method may continue by providing for peer to peer wagering between users, allowing users to view their relative standing amongst various communities, and providing wagers based on a user's standing within a community.

An exemplary embodiment may provide a community building module, where users may create, join, or invite others to a number of communities. Communities may be based on geographical location, broadcast area, user winnings, user rankings, or any other contemplated criteria.

A further embodiment includes the use of a proprietary data management and analytic statistical software system/wagering platforms through which users place wagers on games and are accordingly ranked on a leaderboard and are rewarded based upon the user's respective place on the leaderboard. For example, a leaderboard could display the top one hundred users, but could easily expand to the top one thousand. The present invention includes a proprietary payout structure for users ranked on leaderboards using a data management and analytical software system/wagering platform. Through this data management and analytics software system, users place wagers on games and are ranked on a leaderboard and are reward based upon his or her respective place on the leaderboard. Currently, the leaderboard displays the top one hundred users (but could easily expand to the top one thousand), and users are grouped according to individual rankings (e.g., fourth place through twenty-fifth place, twenty-sixth place through one-hundredth place) and rewarded accordingly (e.g., ten cents to those in twenty-sixth place, twenty-five cents to those in twenty-fifth to fourth place, two dollars to third place, ten dollars to second place, and twenty dollars to first place).

Another embodiment includes a community-based leaderboard, where users of the data management and analytic statistical software/real money wagering system are ranked on leaderboards specific to certain bets/games and, through the use of geolocation, are notified of fellow leaderboard members in attendance at games. For example, a user can scan his or her game ticket into the data management and analytics software system and then receive notifications as to the locations of fellow leaderboard members also in attendance (e.g., number forty is two rows behind you). Furthermore, users can identify fellow leaderboard members at a local sports bar, for example, and create a sub-leaderboard consisting only of those members in attendance. The present invention includes the use of a modification of the current sports wagering system application invention in which it is set up as a peer-to-peer wagering system, where one mobile device acts as the server does in the current invention. For example, this invention can be used in the event that Joe and Mike are watching the game and betting against one other on each play over the course of a game, where the winner will be the one who made the most correct bets during the course of the game. The present invention includes a proprietary method of indicating the winners of peer-to-peer wagers (made through a sports betting application) to those within that peer-to-peer wager by displaying an avatar or image of the winning user within that group on the mobile devices or displays used by those group members.

A system for wagering on individual events in a sporting event. In addition to allowing users to wager on individual events, the system allows the creation of communities of users based upon a number of different factors, including location, team affiliation, betting history, or other common factors. Users can view their standing among their own communities and specialty communities, such as celebrities or experts, on a leaderboard. Wagers can be based upon the user's standing on a leaderboard at the end of a predetermined number of game events. The system further allows users to message other members and propose wagers directly to other players.

### EMBODIMENT 12B

A community building gaming method, comprising: providing a plurality of communities in a real time wagering platform; calculating odds of events within a live sporting event for real time play by play wagering; communicating the odds as available wagers to a user; receiving selected wagers; monitoring event results; determining that two or more users are members of a same community among the plurality of communities in the real time wagering platform; and facilitating communication between the two or more users of the same community of the real time wagering platform.

A betting exchange system community building gaming method, comprising: providing a plurality of communities in a real time wagering platform; allowing layer bettors to provide odds for events within a live sporting event for real time play by play wagering; communicating the odds as available wagers to backing bettors; receiving selected wagers; monitoring event results; determining that two or more layer bettors are members of a same community among the plurality of communities in the real time betting exchange wagering platform; and facilitating communication between the two or more layer bettors of the same community of the real time wagering platform to allow the layer bettors to change their odds for the next bet.

For example, in a betting exchange system method, if two family members are in a “group” defined in the betting exchange system, and one of the family members provided a laying bet of a certain odd level and bet, the second family member would get to see the first family members bet odds and level, allowing the second family member to create a new layer bet.

A machine learning betting system community building gaming method, comprising: providing a plurality of communities in a real time wagering platform; using machine learning, calculating odds of events within a live sporting event for real time play by play wagering; communicating the odds as available wagers to a user; receiving selected wagers; monitoring event results; determining that two or more users are members of a same community among the plurality of communities in the real time wagering platform; and facilitating communication between the two or more users of the same community of the real time wagering platform.

For example, in a machine learning betting system method, an unsupervised learning system can find a pattern of betting of a user, whereby the bettor places bets on a type (for success) of odds and level on a type of event (a punt) and a specific player, and once that is found, the system can, when it finds the same type of event and player is in a current event, the system notifies the game player (who was found to bet on this event and player) of the a new bet with odds and levels that are associated with the learning from the unsupervised machine learning machine.

### EMBODIMENT 13A

### Play by Play Parlay

The embodiments generally relate to wagering on a number of individual actions inside of a live event, for example, through an electronic device interface.

An exemplary embodiment provides a method for providing a parlay in a live sports game. The method may include retrieving live events and multiple possible actions within the live event, presenting the user with one or more wagering options and corresponding odds for the actions, combining one or more actions, calculating odds for the combination of actions based on historical play data, comparing the combination of actions to the result of the actions in the live event, and paying out the user according to the wagering option and result.

An embodiment further includes a method of enticing a user-bettor to place a bet on the last play of one game and the first play of the next scheduled game through the offer of improved odds, for example, to entice bettors to keep betting game after game. This would allow a user to parlay the last event within one game with the first event in another game in order to entice the user to continue to use the wagering platform. For example, the user may be able to bet on the last event of a game being a pass and the first event of another game to be a run and provide the user with increased odds. An embodiment further consists of a proprietary method of continuously building parlays for a series of events within a play. For example, in the wagering platform allowing a user to parlay the wagers for run, a run greater than 4 yards and the run results in a first down. This would provide the user with an increase of odds for the wager since it is a parlay. An embodiment may include a method of providing the option to users of a wagering platform to parlay a sequence of individual plays in order to increase the odds for a wager. Finally, an embodiment includes a method of parlaying the outcomes of drives or a series of events (i.e., with respect to sporting events). For example, a bettor could wager that the first drive will be a three and out, the second drive will end in a touchdown, and the third will be a punt, where the bettor tries to parlay only the outcomes of specific aggregated drives more so than just the specific play.

A method of wagering on a plurality of individual actions inside of a live event as a single wager or parlay. The user is presented with at least one live event on which they can wager on individual actions or plays inside of that live event. The user selects the first play or action they wish to wager on, and are then presented with options to parlay that wager with at least one more play or action. The user can continue to add plays or actions, after each of which the odds for the next play to be added are calculated and presented. When the user has finished constructing their parlay, the live event results are monitored to determine the wager result, and the user's account balance is updated accordingly.

### EMBODIMENT 13B

A method for providing a parlay in a live sports game, comprising: retrieving at least one active live event comprising a plurality of actions upon which wagers can be placed, presenting at least one wagering option on one or more of the plurality of actions inside of the live event, allowing a combination of additional actions to the wagering option in order to change odds or payout of the wagering option, calculating odds of the combination of actions within the wagering option based on at least one of historical play data and past wager activity that is filtered for actions similar to the combination of actions, and comparing the combination of actions to a result of the actions in the live event.

A betting exchange system method for providing a parlay in a live sports game, comprising: retrieving at least one active live event comprising a plurality of actions upon which wagers can be placed, allowing a laying bet of at least one wagering option on one or more of the plurality of actions inside of the live event, allowing a combination of additional actions to the wagering option in order to allow the layer bettor to change odds or payout of the wagering option, allowing the layer better to calculate odds of the combination of actions within the wagering option based on showing at least one of historical play data and past wager activity that is filtered for actions similar to the combination of actions, and showing the combination of actions to the laying bettor as to a result of the actions in the live event, allowing the layer bettor to change their odds and level for a next bet.

For example, in a betting exchange system method, a layer bettor bets on a parlay, that is a series of first downs in a row in football, and the historical play data and past wager activity is filtered and shown to the layer better for actions similar to the combination of actions, showing that success was low to win a bet, and allowing the laying bettor to change (lower) their next parlay laying bets.

A machine learning betting system method for providing a parlay in a live sports game, comprising: retrieving at least one active live event comprising a plurality of actions upon which wagers can be placed, presenting at least one wagering option on one or more of the plurality of actions inside of the live event, allowing a combination of additional actions to the wagering option in order to change odds or payout of the wagering option, using machine learning to calculate the odds of the combination of actions within the wagering option based on at least one of historical play data and past wager activity that is filtered for actions similar to the combination of actions, and comparing the combination of actions to a result of the actions in the live event.

For example, in a machine learning betting system method a supervised machine learning system to correlate “parlay event” to both a first parlay (and the odds and levels of the first parley) and secondary parlays (a second sequence of plays based on the first parlays) an the odds and levels of the second parlay, and offering to game players a first parlay and its odds and levels when the parlay event is found and offering to the game players who chose the first parlay the second parlay.

### EMBODIMENT 14A

### Method of Placing Wagers Through a Mobile Device Through A Television Wagering Platform

The embodiments are generally related to wagering on live sporting events, such as play by play wagering and its interaction with over the top TV equipment.

The embodiments include methods, systems, and apparatuses for placing wagers. One embodiment includes a system integrating play by play sports wagering into the display of a live sporting event, including a mobile device having a first display, a second display, a broadcast of a live sporting event, and a wagering network, where the wagering network provides one or more wagering odds on one or more outcomes for individual plays inside of the live sporting event, and the mobile device controls the integrated display of the wagering odds and the broadcast of the live sporting event on the second display.

Another exemplary embodiment includes a method for displaying wagering information during a live action sporting event, including: displaying a pairing of a mobile device with a first display to a second display; displaying wagering software on the mobile device; displaying, on the mobile device, one or more options related to a type and location of one or more wagering odds on the second display; and displaying, on the mobile device, selections of the one or more wagering odds on the second display based on a selection of the one or more options related to the type and location of the one or more wagering odds.

Another exemplary embodiment can include a method for displaying wagering information during a live action sporting event, including: displaying a pairing of a display to a mobile device; displaying one or more wagering odds in one or more first locations on the display during the live action sporting event in response to a first input on the mobile device; and displaying the one or more wagering odds in one or more second locations on the display during the live action sporting event in response to a second input on the mobile device.

A system for controlling how wagering odds for individual plays inside of a live sporting event are combined with the broadcast of the live sporting event on a display with a mobile device that is paired with a set top box.

### EMBODIMENT 14B

A system integrating play by play sports wagering into the display of a live sporting event, comprising: a mobile device having a first display; a second display; a broadcast of a live sporting event; and a wagering network, wherein the wagering network provides one or more wagering odds on one or more outcomes for individual plays inside of the live sporting event, and the mobile device controls the integrated display of the wagering odds and the broadcast of the live sporting event on the second display.

A betting exchange system integrating play by play sports wagering into the display of a live sporting event, comprising: a mobile device having a first display; a second display; a broadcast of a live sporting event; and a wagering network, wherein the wagering network allows for laying bets one or more events for individual plays inside of the live sporting event, and the mobile device controls the integrated display of the wagering odds and the broadcast of the live sporting event on the second display.

For example, in a betting exchange system method a user may lay a bet on a mobile device interactive display showing betting exchange data and the user can see the live event on an integrated second display of a set top box.

A machine learning betting system integrating play by play sports wagering into the display of a live sporting event, comprising: a mobile device having a first display; a second display; a broadcast of a live sporting event; and a wagering network, wherein the wagering network provides one or more wagering odds on one or more outcomes for individual plays inside of the live sporting event, and the mobile device controls the integrated display of the wagering odds and the broadcast of the live sporting event on the second display.

For example, in a machine learning betting system method, a supervised machine learning system can learn wagering odds and outcomes patterns for individual plays inside a live event and then use this learning to provide one or more wagering odds on one or more outcomes for individual plays inside of the live sporting event, and the mobile device controls the integrated display of the wagering odds and the broadcast of the live sporting event on the second display.

### EMBODIMENT 15A

AR VR in-Play Wagering System

The present disclosure is generally related to wagering on live sporting events. Specifically play by play wagering, and its interaction with augmented reality and virtual reality devices.

The embodiments include methods, systems, and apparatus for in-play wagering using augmented reality and virtual reality. One embodiment incudes a system for wagering on a path of a player or object in a field of play during a single play of a live event through at least one of an augmented reality or virtual reality device, including a wagering network that hosts in-play wagering on live sporting events; at least one of a virtual reality or augmented reality device; a live sporting event, where the live sporting event is displayed through the device; at least two wagers are provided by the wagering network for a single play in the live event and available wagers are filtered by the point of view of the at least one virtual reality or augmented reality device; a placement of an initial wager based on at least one of the at least two wagers provided; at least one additional wager is provided based on movement of one or more elements in the live event that is contingent upon the initial wager being correct; a placement of a second wager based on a predicted movement of the one or more elements in the live action event; and a comparison of a predicted movement of the one or more elements to an actual movement made in the live event and payment for a successful wager.

Another exemplary embodiment includes augmented and/or virtual reality wagering device, including a mobile device running augmented and/or virtual reality software; one or more elements participating in a live event; a display of one or more wagering options in augmented and/or virtual reality based on the point of view of the mobile device with respect to the live event and the one or more elements participating in the live event; and a wagering module that facilitates placement of wagers for the live event.

A system for play by play wagering on a live sporting event through an augmented reality or virtual reality device. Users of a play by play wagering network can place wagers on the outcome of individual plays in a live sporting event that are displayed based on the players or elements of the live event that are in the point of view of the user's virtual or augmented reality device. Selected wagers can be augmented with multipliers based on user's manipulation of the augmented or virtual reality environment, such as running a path through the virtual field that they believe a player will take.

### EMBODIMENT 15B

A system for wagering on a path of a player or object in a field of play during a single play of a live event through at least one of an augmented reality or virtual reality device, comprising: a wagering network that hosts in-play wagering on live sporting events; at least one of a virtual reality or augmented reality device; a live sporting event, wherein the live sporting event is displayed through the device; wherein at least two wagers are provided by the wagering network for a single play in the live event and available wagers are filtered by the point of view of the at least one virtual reality or augmented reality device; a placement of an initial wager based on at least one of the at least two wagers provided at least one additional wager is provided based on movement of one or more elements in the live event that is contingent upon the initial wager being correct; a placement of a second wager based on a predicted movement of the one or more elements in the live action event; and a comparison of a predicted movement of the one or more elements to an actual movement made in the live event and payment for a successful wager.

A betting exchange system for wagering on a path of a player or object in a field of play during a single play of a live event through at least one of an augmented reality or virtual reality device, comprising: a wagering network that hosts in-play wagering on live sporting events; at least one of a virtual reality or augmented reality device; a live sporting event, wherein the live sporting event is displayed through the device; wherein at least two wagers are accepted by layer bettors in the wagering network for a single play in the live event and available wagers, where the layer bets are filtered by the point of view of the at least one virtual reality or augmented reality device; a placement of an the initial layer wager bet based on at least one of the at least layer bet wagers allowing at least one additional layer wager bet based on movement of one or more elements in the live event that is contingent upon the initial layer wager; a placement of a second layer wager bet based on a predicted movement of the one or more elements in the live action event; and a comparison of a predicted movement of the one or more elements to an actual movement made in the live event and payment by the betting exchange for a successful wager.

For example, in a betting exchange system method, a first layer bettor places a bet for a first movement of a first player and the is allowed to place a second layer bet for a second movement. The betting exchange will allow more laying bets based upon the next predict movements for the movement of the players.

A machine learning betting system for wagering on a path of a player or object in a field of play during a single play of a live event through at least one of an augmented reality or virtual reality device, comprising: a wagering network that hosts in-play wagering on live sporting events; at least one of a virtual reality or augmented reality device; a live sporting event, wherein the live sporting event is displayed through the device; wherein at least two wagers are provided, based upon machine learning of the wagering network for a single play in the live event and available wagers are filtered by the point of view of the at least one virtual reality or augmented reality device; a placement of an initial wager based on at least one of the at least two wagers provided at least one additional wager is provided based on movement of one or more elements in the live event that is contingent upon the initial wager being correct; a placement of a second wager based on a predicted movement of the one or more elements in the live action event; and a comparison of a predicted movement of the one or more elements to an actual movement made in the live event and payment for a successful wager.

For example, the machine learning betting system uses unsupervised learning to find relationships between players movements and bets to allow for new predicted movements to have bets related to the relationships found in the unsupervised learning.

### EMBODIMENT 16A

### Method of Tracking User Bets to Ensure Compliance

The embodiments are generally related to a method of tracking user bets to ensure compliance or detect cheating by monitoring a user's betting habits.

A method of monitoring user behavior to adjust betting odds based upon that behavior or to identify users who may be cheating, where users are subscribers of a proprietary data management and analytic software system/wagering platform. The system monitors users' behavior for deviations from their normal betting habits or patterns to detect cheating and lower the threshold for winning when user patterns change.

### EMBODIMENT 16B

A method of tracking user wagers to ensure compliance, comprising: storing historical wager history and/or wager patterns of a user in a user database; calculating a change in the wager patterns of a user by comparing current wager activity of the user with the historical wager activity in the user database; identifying a change in wager activity of the user; and calculating a new winnings threshold for new wager patterns identified of the user.

A betting exchange system method of tracking laying wagers of users to ensure compliance, comprising: storing historical laying wager history and/or laying wager patterns of a user in a user database; calculating a change in the layer wager patterns of a user by comparing current laying wager activity of the user with the historical laying wager activity in the user database; identifying a change in laying wager activity of the user; and showing a new winnings threshold for new layer wager patterns to the layer bettor in order to allow the layer bettor to place more lay bets.

For example, in a betting exchange system method, if a layer bettor is placing bets over time, they are tracked thru history with their wining threshold being calculated, and then showing to the layer bettor their winning history at a next event in the game to entice the layer bettor to place a new laying bet.

A machine learning betting system method of tracking user wagers to ensure compliance, comprising: storing historical wager history and/or wager patterns of a user in a user database; using machine learning to calculate a change in the wager patterns of a user by comparing current wager activity of the user with the machine learning on the historical wager activity in the user database; identifying a change in wager activity of the user; and using machine learning to calculate a new winnings threshold for new wager patterns identified of the user.

For example, in a machine learning betting system method, machine learning can learn the history of a user and when and how much the user is likely to bet, and this learned data provides thresholds (ranges of types and amount of bets at various odds) learned by machine learning and this data is used when offering the next bet to the user.

### EMBODIMENT 17A

### Method of Using Video and AI in Wagering

The embodiments are generally related to wagering on paths taken by players or objects inside of individual plays of a sporting event.

The embodiments include methods, systems, and apparatuses for using video and artificial intelligence in wagering. One embodiment includes a method for wagering on the path of a player or object in the field of play during a single play of a live event and displaying a probabilistic outcome over video of the live event, including retrieving at least one active live event upon which wagers can be placed on plays occurring inside of that live event, presenting at least one wagering option on a play occurring inside of the live event, selecting a path of at least one player or object in a field of play inside the live event for making at least one wager, making a path wager on the selected path, displaying the selected path over a display of the live event, and comparing movement of players and/or objects in the field of play to historical video of the same players in similar plays from at least one of one or more previous live events and previous movements of the players in the current live event, determining a projected path of the player and/or object, overlaying the projected path of the player and/or object over the live event display, and adjusting display of the overlaid projected path based on a confidence in the projection.

Another embodiment includes a computer implemented method for wagering on the path of a player or object on the field of play during a single play of a live event, including executing on a processor the steps of displaying at least one active live event upon which wagers can be placed on plays occurring inside of that live event, displaying at least one wagering option on a play occurring inside of the live event, displaying a path, on an interface, of at least one player or object in a field of play inside the live event for making at least one wager, displaying a path wager placed on the selected path, displaying the user selected path over a display of the live event, overlaying a projected path of the player or object over the live event display, adjusting display of the overlaid projected path during the play in the live event; and displaying an output of the path wager.

A system and method for utilizing video analysis to enhance in-play sports wagering by overlaying potential play outcomes with the live video and adjusting the display of the potential outcomes based on the video analysis of the actual play's outcome.

### EMBODIMENT 17B

A method for wagering on the path of a player or object in the field of play during a single play of a live event and displaying a probabilistic outcome over video of the live event, comprising: retrieving at least one active live event upon which wagers can be placed on plays occurring inside of that live event; presenting at least one wagering option on a play occurring inside of the live event; selecting a path of at least one player or object in a field of play inside the live event for making at least one wager; making a path wager on the selected path; displaying the selected path over a display of the live event; comparing movement of players and/or objects in the field of play to historical video of the same players in similar plays from at least one of one or more previous live events and previous movements of the players in the current live event; determining a projected path of the player and/or object; overlaying the projected path of the player and/or object over the live event display; and adjusting display of the overlaid projected path based on a confidence in the projection.

A betting exchange system method for wagering on the path of a player or object in the field of play during a single play of a live event and displaying a probabilistic outcome over video of the live event, comprising: retrieving at least one active live event upon which laying wagers can be placed on plays occurring inside of that live event; allowing at least one laying wager on a play occurring inside of the live event; selecting a path of at least one player or object in a field of play inside the live event for making at least one laying wager; making a path laying wager on the selected path; displaying the selected path over a display of the live event; comparing and showing to the laying bettor the movement of players and/or objects in the field of play to historical video of the same players in similar plays from at least one of one or more previous live events and previous movements of the players in the current live event; determining a projected path of the player and/or object; overlaying the projected path of the player and/or object over the live event display; and adjusting display of the overlaid projected path based on a confidence in the projection and allowing for additional laying bets on the projections.

For example, in a betting exchange system method, laying bettors can bet on a selected path they chose or bet of a predicted path the system choses.

A machine learning betting system method for wagering on the path of a player or object in the field of play during a single play of a live event and displaying a probabilistic outcome over video of the live event, comprising: retrieving at least one active live event upon which wagers can be placed on plays occurring inside of that live event; presenting at least one wagering option on a play occurring inside of the live event; selecting a path of at least one player or object in a field of play inside the live event for making at least one wager; making a path wager on the selected path; displaying the selected path over a display of the live event; comparing movement of players and/or objects in the field of play to historical video of the same players in similar plays from at least one of one or more previous live events and previous movements of the players in the current live event; determining using machine learning a projected path of the player and/or object; overlaying the projected path of the player and/or object over the live event display; and adjusting display of the overlaid projected path based on a confidence in the projection.

For example, in a machine learning betting system method, a supervised machine learning system can pre calculate predicted paths for specific player for plays or events to use in determining projected paths.

### EMBODIMENT 18A

Method of Using Player Third Party Data Integrated with Player Sensor Data

The embodiments are generally related to integrating third party analytical data into in-play sports wagering platforms.

A system to provide the user of an in play wagering system with access to third party data analytics services and integrates the user's selection of available data analytics with the display of a live sporting event and the wagers available on a given play in the sporting event.

### EMBODIMENT 18B

A system to provide at least one set of third party analytics data to users of gambling games, the system comprising: a wagering network that hosts in-play wagering on live sporting events; at least one third party network provider of sports analytics; data received from a live sporting event; odds generated for single play outcomes for the live sporting event; and data received from an end user device indicating how to display both the third party analytics data and the odds for single play outcomes on the end user device.

A betting exchange system to provide at least one set of third party analytics data to users of gambling games, the system comprising: a wagering network that hosts in-play wagering on live sporting events; at least one third party network provider of sports analytics; data received from a live sporting event; odds generated by laying bettors for single play outcomes for the live sporting event; and data received from an end user device indicating how to display both the third party analytics data and the odds for single play outcomes on the end user device.

For example, in a betting exchange system method the laying bettor may want to see analytics for their lineup of next players to plan on placing a new laying bet.

A machine learning betting system to provide at least one set of third party analytics data to users of gambling games, the system comprising: a wagering network that hosts in-play wagering on live sporting events; at least one third party network provider of sports analytics; data received from a live sporting event; odds generated for single play outcomes for the live sporting event; and data received from machine learning indicating how to display both the third party analytics data and the odds for single play outcomes on the end user device.

For example, in a machine learning betting system method, the unsupervised machine learning learns how various bettors wants to view their type of analytics, and the unsupervised machine learning makes recommendations for the bettor display user interface.

### EMBODIMENT 19A

### A Method and System for Integrating Bank Data and Platforms on a Wagering Platform

The embodiments are generally related to integrating banking platforms for in-play sports wagering platforms.

The accompanying drawings illustrate various embodiments of systems, methods, and various other aspects of a bank network integrated into a gambling platform. One embodiment includes a system to provide banking services to users of gambling games, the system including a live event, a wagering network that hosts in-play wagering on live events; at least one bank network; and at least one risk limitation of the wagering network, where the bank network ensures wagers on the live event fall inside of the at least one s risk limitation before a wager is placed with the wagering network.

Another exemplary embodiment includes a computer implemented method for providing bank services to users of gambling games, including executing on a processor the steps of: providing a gambling game on a device; providing a portal to enter credentials associated with the gambling game; communicatively coupling the gambling game to a bank network having bank account information; setting at least one risk limitation on wagers made in the gambling game; accepting one or more wagers in the gambling game; comparing the one or more wagers to the at least one risk limitation; and allowing the wager if the risk limitations are satisfied, or preventing the wager if the risk limitations are not satisfied.

Still another exemplary embodiment includes a computer implemented method for providing third party banking services for gambling games, including executing on a processor the steps of displaying a gambling game on a device; displaying or more bank account options to couple with the gambling game; displaying risk limitations to select, the risk limitations associated with a coupled bank account; displaying one or more wagering options; displaying one or more made wagers; and displaying a message indicating that the one or more made wagers was prevented based on a comparison of any selected risk limitations to the wager indicating at least a risk limitation was not met.

A system to provide the user of an in play wagering systemin which all of the user's wallet information is handled by a third party bank network keeping user account information private from the wagering system while providing the wagering system with verification of the user's ability to cover the wager as well ensure the wager is below user specific risk limitations.

### EMBODIMENT 19B

A system to provide banking services to users of gambling games, the system comprising: a live event, a wagering network that hosts in-play wagering on live events; at least one bank network; and at least one risk limitation of the wagering network; wherein the bank network ensures wagers on the live event fall inside of the at least one risk limitation before a wager is placed with the wagering network.

A betting exchange system to provide banking services to users of betting exchanges gambling games, the system comprising: a live event, a wagering network that hosts in-play wagering on live events; at least one bank network; and at least one risk limitation of the wagering network; wherein the bank network ensures laying bettors of the live event fall inside of the at least one s risk limitation before a laying bet wager is placed with the wagering network.

For example, in a betting exchange system method a laying bettor may provide their banking information for their banking network (personal bank) in the betting exchange, or other 3rd party banking systems designed to interact with betting exchanges, and the banking network would provide “risk” data to the laying bettor before the laying bet is approved.

A machine learning betting system to provide banking services to users of gambling games, the system comprising: a live event, a wagering network that hosts in-play wagering on live events; at least one bank network; and at least one risk limitation of the wagering network; wherein the bank network uses supervised machine learning to calculate risks for wagerers and the bank network uses this supervised machine learning to ensures wagers on the live event fall inside of the at least one risk limitation before a wager is placed with the wagering network.

For example, in a machine learning betting system method, the supervised machine learning system finds out that bettors usually place small bets of about 5% of their personal bank, for 95% of their bets, and when two successive 25% of the personal bank is best, a risk is highlighted to the user before the second 25% of the personal bank bet can be accepted.

### EMBODIMENT 20A

### Player Focused Wagering System

The embodiments are generally related to play by play wagering on live sporting events focused on individual players.

Embodiments can include various methods, systems, and apparatuses for wagering. One embodiment includes a system for wagering on multiple elements of a single play of a live sporting event related to a player of interest, including: a wagering network that hosts in-play wagering on live sporting events; and a user database with user preferences; odds for wagers are available on multiple potential outcomes for single plays inside of a live sporting event; and wagers are offered on the wagering network on potential outcomes for a favorite player in a play of a live sporting event.

Another exemplary embodiment includes a computer implemented method for providing wagering on multiple elements of a single play of a live sporting event related to a player of interest, including executing on a processor the steps of: displaying a gambling game on a device; displaying one or more favorite players or, if there are no favorite players, prompting a selection of one or more favorite players; displaying one or more first wager options for at least one favorite player in play in a live sporting event; and displaying one or more wagers placed on the at least one favorite player in the play in the live sporting event.

A system for player focused play by play wagering on live sporting events in which users identify favorite players and a wagering network offers that user player focused wagering opportunities and allow the user to build upon that wager with new player focused wagering opportunities that are based upon their previous wagering selections.

### EMBODIMENT 20B

A system for wagering on multiple elements of a single play of a live sporting event related to a player of interest, comprising: a wagering network that hosts in-play wagering on live sporting events; a user database with user preferences; odds for wagers are available on multiple potential outcomes for single plays inside of a live sporting event; and wagers are offered on the wagering network on potential outcomes for a favorite player in a play of a live sporting event.

A betting exchange system for wagering on multiple elements of a single play of a live sporting event related to a player of interest, comprising: a wagering network that hosts in-play exchange wagering on live sporting events; a user database with user preferences; allowing laying bettors to create odds and values for wagers on multiple potential outcomes for single plays inside of a live sporting event; and laying bettor wagers are offered on the wagering network on potential outcomes for a favorite player in a play of a live sporting event.

For example, in a betting exchange system method, the betting exchange allows laying bets that meets the ranges set earlier by a laying bettor.

A machine learning betting system for wagering on multiple elements of a single play of a live sporting event related to a player of interest, comprising: a wagering network that hosts in-play wagering on live sporting events; a user database with user preferences; odds for wagers are calculated using unsupervised machine learning and they are made available on multiple potential outcomes for single plays inside of a live sporting event; and wagers are offered on the wagering network on potential outcomes for a favorite player in a play of a live sporting event.

For example, in a machine learning betting system method, the unsupervised machine learning learns in real time the odds for wagers the user may be willing to make, as well as how well these odds fit into predefined user preferences, and these odds and preferences are made available to find the best odds for the house (most profit) for the user.

### EMBODIMENT 21A

### Wager Sharing and Invitation Method

The embodiments are generally related to wagering on live sporting events, and specifically play by play wagering and the sharing of wagers.

Embodiments can include methods, systems, and apparatuses for making and sharing wagers on single plays in a live event in real time. One embodiment includes a method of sharing a wager placed by a first user on a single play inside of a live sporting event a wagering network; including receiving data from a live sporting event upon which wagers can be placed on plays inside of that live event, and placing a wager, by at least a first user, on a play in the live event, where the user shares the wager.

Another exemplary embodiment includes a system for placing and sharing wagers on a single play taking place during a live sporting event, including: a wagering network that facilitates wagering in real time on single plays taking place during a live sporting event; a wagering terminal that facilitates placing individual wagers, the wagering terminal communicatively coupled to the wagering network; a wager sharing module that is prompted by the placement of a first wager on the wagering terminal, the wager sharing module providing a list of contacts on the wagering terminal; and a notification sent to one or more contacts on the contact list from the wagering terminal.

Another embodiment includes a computer implemented method for placing and sharing wagers placed on a wagering network, including executing on a processor the steps of: displaying an interface of a wagering game for wagering in real time on single plays taking place during a live sporting event; displaying one or more wagering options; displaying a placed wager; displaying a list of contacts; and displaying a notification that a message has been sent to one or more contacts in the list of contacts, the notification related to the placed wager.

A method of sharing a wager on a live sporting event with another individual on a play by play wagering platform. Users can additionally invite other users to place the same wager or another wager on a different play. Upon accepting a wager invitation, the users additionally joining a chat conversation so as to communicate while placing wagers on the live sporting event.

### EMBODIMENT 21B

A method of sharing a wager by a first user on a one or more plays inside of a live sporting event a wagering network; comprising receiving data from a live sporting event upon which wagers can be placed on plays inside of that live event, determining odds for real time wagering on at least one play of the plays inside the live sporting event by comparing historical data with situational data of the live sporting event, and placing a wager, by at least a first user, on the at least one play in the live sporting event where odds are determined, wherein the user shares the wager.

A betting exchange system method of sharing a laying wager by a first user on a one or more plays inside of a live sporting event a wagering network; comprising receiving data from a live sporting event upon which laying wagers can be placed on plays inside of that live event, wherein the laying bettor can receive odds for real time wagering on at least one play of the plays inside the live sporting event by comparing historical data with situational data of the live sporting event to the first laying bettor odds, and allowing a laying bettor to place a second wager, by the first laying bettor, on the at least one play in the live sporting event where the new odds of the laying bettor are inputted, wherein the user shares the laying wager.

For example, in a betting exchange system method, the laying bettor places a bet and then receives data of how historical data and situational data compare, for instance the laying bet is $10 at 3:1, but the historical data and situational data would show bets at 2.5:1 for $5 as the norm, so the laying bettor may place a second wager on the same play at possible more conservative odds.

A machine learning betting system method of sharing a wager by a first user on a one or more plays inside of a live sporting event a wagering network; comprising receiving data from a live sporting event upon which wagers can be placed on plays inside of that live event, determining using supervised machine learning, odds for real time wagering on at least one play of the plays inside the live sporting event by comparing historical data with situational data of the live sporting event, and placing a wager, by at least a first user, on the at least one play in the live sporting event where odds are determined, wherein the user shares the wager.

For example, in a machine learning betting system method, the supervised machine learning determine odds that would be best received and bet on by bettors for an upcoming play that correlated to both historical data and situational data.

### EMBODIMENT 22A

### AI Sports Betting Algorithms Engine

The embodiments are generally related to gambling on individual plays inside of a live sporting event and the odds calculations related to that.

This invention is an engine that allows, for any play in an “in play” or single play betting game, that both calculates “basic odds” (calculated by using historical database mining) and at least one more odds making formula to calculate odds on at least one outcome of a single play in a live event, crossing at least two different odds making formulas to create crossed odds. Then utilizes artificial intelligence to correlate the crossed odds with the final odds on similar historical plays in which odds were calculated. Then utilizes machine learning after the outcome of the play is known to correlate the odds generated by each odds making formula with the most profitable odds calculated on previous similar plays.

### EMBODIMENT 22B

A method of calculating odds on at least one outcome of at least one play in a live sporting event, comprising: receiving data related to a live sporting event on a wagering network, and calculating at least first odds on at least one outcome of at least one play in a live sporting event using at least a first odds calculation formula, calculating at least second odds on the at least one outcome of the at least one play in the live sporting event using at least a second odds calculation formula, calculating odds on the at least one outcome of the at least one play in the live sporting event using a combination of the first odds calculation formula and the at least second two odds calculation formula, quantifying a value of odds created by at least two odds calculation formulas in similar, previous live sporting events and/or plays inside of the similar, previous live sporting events, and offering final odds for wagers based on quantified odds meeting a threshold.

A betting exchange system method of calculating lay odds on at least one outcome of at least one play in a live sporting event, comprising: receiving data related to a live sporting event on a wagering network, and calculating at least first lay odds to provide to a lay bettors on at least one outcome of at least one play in a live sporting event using at least a first odds calculation formula, calculating at least second lay odds to a lay bettor on the at least one outcome of the at least one play in the live sporting event using at least a second lay odds calculation formula, calculating lay odds on the at least one outcome of the at least one play in the live sporting event using a combination of the first lay odds calculation formula and the at least second two lay odds calculation formula, quantifying a value of lay odds created by at least two way odds calculation formulas in similar, previous live sporting events and/or plays inside of the similar, previous live sporting events, and offering final lay odds for wagers based on quantified odds meeting a threshold.

For example, in a betting exchange system method we would determine first lay odds using historical data of the players in the play and we could calculate a second lay odds based up current lay bettors behavior and create the final lay odds as the average of the two.

A machine learning betting system method of calculating odds on at least one outcome of at least one play in a live sporting event, comprising: receiving data related to a live sporting event on a wagering network, and using machine learning to calculate at least first odds on at least one outcome of at least one play in a live sporting event using at least a first odds using machine learning calculation, calculating at least second odds on the at least one outcome of the at least one play in the live sporting event using at least a second using machine learning to calculation, calculating odds on the at least one outcome of the at least one play in the live sporting event using a combination of the first machine learning calculated odds calculation formula and the at least second two machine learning calculation odds, quantifying a value of odds created by at least two odds machine learning calculations, and offering final odds for wagers based on quantified odds meeting a threshold.

For example, in a machine learning betting system method, we would determine first odds using supervised learning on historical data of the players in the play and we could calculate a second odds based upon a unsupervised learning machine on current bettors behaviour, and create the final lay odds as the average of the two.

### EMBODIMENT 23A

### Wager Odds Balancing Method

The embodiments are generally related to wagering on live sporting events such as, play by play wagering and the mitigation of exposure.

A method, system, and apparatus for balancing wagering odds. In one embodiment, a method of reducing exposure of a wagering network by incentivizing targeted users can include receiving data from a live sporting event upon which wagers can be placed on single plays inside of the live event, measuring a balance of wagers on each potential outcome of the single plays, identifying instances in which the balance of wagers raises exposure of the wagering network above a threshold, and identifying users who have selected a wager opposite the exposure, and offering one or more incentives to the identified users to increase a wager amount.

In another exemplary embodiment, a method for providing updated wagering options on a wagering network for single play wagering can include, executing on a processor the steps of, displaying a wagering platform; displaying one or more wagers for wagering on a single play of a live sporting event; displaying a selected wager; and displaying improved odds after the wager is selected.

A method of reducing the exposure of a wagering network when the exposure exceeds a threshold due to an imbalance of wagers placed on one outcome compared to other outcomes by offering updated odds to users having placed wagers on less favored outcomes and further offering to update the odds of their original wager if they increase their wager amount to incentivize the users to increase their wager, thus reducing the exposure of the wagering network.

### EMBODIMENT 23B

A method of reducing exposure of a wagering network by incentivizing targeted users, comprising: receiving data from a live sporting event upon which wagers can be placed on single plays inside of the live event; measuring a balance of wagers on each potential outcome of the single plays; identifying instances in which the balance of wagers raises exposure of the wagering network above a threshold; identifying users who have selected a wager opposite the exposure; and offering one or more incentives to the identified users to increase a wager amount.

A betting exchange system method of reducing exposure of a wagering network by incentivizing targeted users, comprising: receiving data from a live sporting event upon which wagers can be placed on single plays inside of the live event; calculating the real time profit of the betting exchange on each potential outcome of the single plays; identifying instances in which the betting exchange profit raises exposure or loss of the wagering network above a threshold; identifying users who have selected a wager opposite the exposure; and offering one or more incentives to the identified users to increase a wager amount.

For example, in a betting exchange system method, if profit is going down because there are less betting volume, the betting exchange system targets lay bettors who have high bet volume to provide gifts or coupons to place more lay bets.

A machine learning betting system method of reducing exposure of a wagering network by incentivizing targeted users, comprising: receiving data from a live sporting event upon which wagers can be placed on single plays inside of the live event; measuring a balance of wagers on each potential outcome of the single plays; identifying instances in which the balance of wagers raises exposure of the wagering network above a threshold; identifying users who have selected a wager opposite the exposure; and using machine learning to determine incentive offering, and offering one or more of these machine learning determination of offerings as incentives to the identified users to increase a wager amount.

For example, in a machine learning betting system method an unsupervised machine learning module would determine the types of incentives, for instance sports memorabilia of a favorite player might be better for a avid bettor of a particular player, and where a cash incentive may be better for a bettor that doesn't appear to have a favorite player or team.

### EMBODIMENT 24A

### Incremental Wager Method

The embodiments are generally related to wagering on live sporting events, specifically increasing wager amounts while play by play wagering.

A method of encouraging a user to increase their wager on a play by play wagering platform by determining the likelihood the user will increase their wager based upon their wager history and proposing an increase amount based upon their likelihood of increasing their wager such that a higher likelihood of increase results in a higher proposed increase amount and a lower likelihood results in a lower proposed increase amount.

### EMBODIMENT 24B

A method of adjusting placement of a next wager on an outcome of a single play in a live sporting event by a specific increment, comprising: storing, in a database, past wagers, providing a default wager option for a wager on a next play in a live sporting event; comparing, by an incremental wagering module, information about one or more past wagers to context of the next play in the live sporting event; determining, by the incremental wagering module, a specific wager adjustment increment based on the comparison of the one or more past wagers to the context of the next play in the live sporting event; and providing, by the incremental wagering module, a proposed adjusted wager corresponding to the specific wager adjustment increment for the wager on the next play in the live sporting event.

A betting exchange system method of adjusting placement of a next lay wager on an outcome of a single play in a live sporting event by a specific increment, comprising: storing, in a database, past lay wagers, providing a default lay wager option for a lay wager on a next play in a live sporting event; comparing, by an incremental wagering module, information about one or more past lay wagers to context of the next play in the live sporting event; determining, by the incremental wagering module, a specific lay wager adjustment increment based on the comparison of the one or more past lay wagers to the context of the next play in the live sporting event; and providing, by the incremental wagering module, a proposed adjusted lay wager corresponding to the specific lay wager adjustment increment for the lay wager on the next play in the live sporting event.

For example, in a betting exchange system method if history of lay betting for a particular event, say a punt in football is usually a large lay bet for a home game, than the next time a punt event occurs in a home game, the lay wager would adjusted higher than average on non-home games.

A machine learning betting system method of adjusting placement of a next wager on an outcome of a single play in a live sporting event by a specific increment, comprising: storing, in a database, past wagers, providing by using machine learning a default wager option for a wager on a next play in a live sporting event; comparing, by an incremental wagering module, information about one or more past wagers to context of the next play in the live sporting event; determining, by the incremental wagering module, a specific wager adjustment increment based on the comparison of the one or more past wagers to the context of the next play in the live sporting event; and providing, by the incremental wagering module, a proposed adjusted wager corresponding to the specific wager adjustment increment for the wager on the next play in the live sporting event.

For example, in a machine learning betting system method, a supervised machine learning module uses historical players data for finding default odds to start with. In another example an unsupervised real time machine learning module is used to find trends of odd changes and default odds are created by the unsupervised machine learning module on trend data.

### EMBODIMENT 25A

### Automatic Wager Method

The embodiments are generally related to Wagering on live sporting events, specifically auto-betting using a play by play wagering system.

A method and system for determining and setting wagers in a real time play by play wagering platform. One embodiment includes a system for setting a value of a next wager on an outcome of a single play in a live sporting event; including a database storing past wagers, an odds database that generates odds for wagers on a next play in a live sporting event; a wager proposal module; where the wager proposal module identifies a most likely wager size for the next play based on one or more past wagers and context of the next play.

Another embodiment includes a method for setting a value of a next wager on an outcome of a single play in a live sporting event; including storing past wagers in a database; generating odds for wagers on a next play in a live sporting event; comparing context of the next play with wagers on similar plays among the past wagers in the database; and proposing a most likely wager size for the next play based on the comparison of the context of the next play with the wagers on the similar plays among the past wagers in the database.

A method of selecting a wager during a live event on a play by play wagering platform to offer to a user such that a wager includes a win condition, odds, and a wager amount based upon the previous wager history of a user. The user being provided the option to accept or decline the wager as offered.

### EMBODIMENT 25B

A system for setting a value of a next wager on an outcome of a single play in a live sporting event; comprising: a database storing past wagers; and an odds database that generates odds for wagers on a next play in a live sporting event; a wager proposal module; wherein the wager proposal module identifies a most likely wager size for the next play based on one or more past wagers and context of the next play.

A betting exchange system for setting a value of a next lay wager on an outcome of a single play in a live sporting event; comprising: a database storing past initial lay wagers; and an odds database that generates odds for lay wagers on a next play in a live sporting event; a lay wager proposal module; wherein the lay wager proposal module identifies a most likely lay wager size for the next play based on one or more past lay wagers and context of the next play.

For example, in a betting exchange system method, the context could be where the football is (5 yard line near the goal with 25 seconds left to win the game) relative to making a lay wager, where there would be a lot of excitement for making larger lay wagers, versus the context being the first down of the first quarter, where they may be less excitement.

A machine learning betting system for setting a value of a next wager on an outcome of a single play in a live sporting event; comprising: a database storing past wagers; and an odds database that generates odds for wagers on a next play in a live sporting event; a wager proposal module; wherein the wager proposal module using machine learning identifies a most likely wager size for the next play based on one or more past wagers and context of the next play.

For example, in a machine learning betting system method, a supervised machine learning module learns wagers that are accepted for a next play based upon both past wagers and context, for example its is found that is a event where the context is that a football game is at the 5 yard line near the goal with 25 seconds left to win the game and that many bets are made, versus the context being the first down of the first quarter, where they may be less bets.

### EMBODIMENT 26A

### In-Play Wagering Through a Fantasy Software Application

The embodiments are generally related to wagering on micro markets and sub outcomes of live sporting events and integrating that wagering with fantasy sports.

The embodiments include methods, systems and apparatuses for wagering in real time on single plays in sporting events through a fantasy sports software application. One embodiment includes a system for wagering on single plays inside of a live sporting event through a fantasy sports platform, including a fantasy sports network, a connection to a wagering network; at least player on a roster of players active in at least one live sporting event on the fantasy sports network, the roster of players selected as a fantasy team in the fantasy sports network, and one or more available singled play wagers from the wagering network on players that are on the roster of players are provided through the fantasy sports network, the available wagers from the wagering network determined by a comparison of the players on the roster of players with data received from the at least one live sporting event.

Another exemplary embodiment includes a method of wagering on single plays inside of a live sporting event through a fantasy sports platform, including executing on a processor the steps of displaying a fantasy sports app; displaying one or wagers accessible in the fantasy sports app, wherein the one or more wagers are real time single play wagers; displaying a roster of players active in one or more live sporting events, the roster of players selected as fantasy team in the fantasy sports app; and displaying one or more wagers available to be placed on at least one player of the roster of players active in the one or more live sporting events.

Still another embodiment includes a system for wagering on single plays inside of a live sporting event through a fantasy sports platform, including a wagering network, a connection to a fantasy sports network a roster of players active in at least one live sporting event on the fantasy sports network, the roster of players selected as a fantasy team in the fantasy sports network, and one or more available wagers from the wagering network on players that are on the roster of players are provided through the fantasy sports network, the available wagers from the wagering network determined by a comparison of the players on the roster of players with data received from the at least one live sporting event.

A system for wagering on sub-outcomes of a live sporting event through a fantasy sports network, in which the wagers displayed for the user are related to the makeup of the user's fantasy roster.

### EMBODIMENT 26B

A system for wagering on single plays inside of a live sporting event through a fantasy sports platform, comprising: a fantasy sports network; a connection to a wagering network; at least player on a roster of players active in at least one live sporting event on the fantasy sports network, the roster of players selected as a fantasy team in the fantasy sports network; and one or more available singled play wagers from the wagering network on players that are on the roster of players are provided through the fantasy sports network, the available wagers from the wagering network determined by a comparison of the players on the roster of players with data received from the at least one live sporting event.

A betting exchange system for wagering on single plays inside of a live sporting event through a fantasy sports platform, comprising: a fantasy sports network; a connection to a wagering network; at least one player on a roster of players active in at least one live sporting event on the fantasy sports network, the roster of players selected as a fantasy team in the fantasy sports network; and one or more available singled laying play wagers from the wagering network on players that are on the roster of players are provided through the fantasy sports network, the available laying wagers from the wagering network determined by a comparison of the players on the roster of players with data received from the at least one live sporting event.

For example, in a betting exchange system method, a user is watching a live event but also has a predefined fantasy team, and if a fantasy team member is currently playing in a current live event, the exchange will match the players of the live event to the fantasy players of the user and then create a laying bet opportunity to the user for the matched player.

A machine learning betting system for wagering on single plays inside of a live sporting event through a fantasy sports platform, comprising: a fantasy sports network; a connection to a wagering network; at least one player on a roster of players active in at least one live sporting event on the fantasy sports network, the roster of players selected as a fantasy team in the fantasy sports network; and one or more available singled play wagers from the wagering network on players that are on the roster of players are provided through the fantasy sports network, the available wagers from the wagering network determined by machine learning and using a comparison of the players on the roster of players with data received from the at least one live sporting event.

For example, in a machine learning betting system method, a user is watching a live event but also has a predefined fantasy team, and if a fantasy team member is currently playing in a current live event, the network will match the players of the live event to the fantasy players and the system will use supervised machine learning of each player for all events and help determine best bet to offer the user and then create a bet opportunity to the user for the matched player.

### EMBODIMENT 27A

### Gaming During Breaks in Live Sporting Events

The embodiments are generally related to wagering on live sporting events, such as engaging users during breaks in the action of a live sporting event.

The embodiments can include methods, systems and apparatuses for providing games to players of a single play wagering platform during breaks in action of sporting events which are being wagered on. One embodiment includes a method of delivering casino games inside of a play by play wagering game, including receiving data from a live sporting event upon which single play wagers can be played on plays inside of that live sporting event, receiving at least one wager from at least one user, monitoring the live sporting event for a break in action of the live sporting event, determining that there is a break in the action of the live sporting event, and providing at least one casino game during the break in action where the at least one casino game is selected based upon at least one characteristic of at least one wager made.

Another exemplary embodiment includes a method of providing game play inside of a play by play wagering platform, including executing on a processor the steps of displaying a wagering game on a wagering platform; displaying one or more real time wagers based on one or more live sporting events; displaying that a break in action of the one or more live sporting events has occurred; and displaying one or more casino game options triggered as a result of the break in action of the one or more live sporting events.

Still another exemplary embodiment includes a method of providing games inside of a play by play wagering game, including receiving data from a live sporting event upon which single play wagers can be played on plays inside of that live sporting event, receiving at least one wager from at least one user, monitoring the live sporting event for a break in action of the live sporting event, determining that there is a break in the action of the live sporting event, and providing at least one game during the break in action where the at least one game is selected based upon at least one characteristic of at least one wager made.

A method of offering casino games to users of a play by play wagering network. The play by play wagering network will offer wagers on individual plays inside of a live sporting event and monitors that live sporting event for breaks in the action. The wagering network then offers the user a casino game, such as roulette or poker, based on at least one characteristics of at least one of the user's previous wagers.

### EMBODIMENT 27B

A method of delivering casino games inside of a play by play wagering game, comprising: receiving data from a live sporting event upon which single play wagers can be played on plays inside of that live sporting event; receiving at least one wager from at least one user; monitoring the live sporting event for a break in action of the live sporting event; determining that there is a break in the action of the live sporting event; and providing at least one casino game during the break in action where the at least one casino game is selected based upon at least one characteristic of at least one wager made.

A betting exchange system method of delivering casino games inside of a play by play wagering game, comprising: receiving data from a live sporting event upon which single play wagers can be played on plays inside of that live sporting event; receiving at least one laying wager from at least one user; monitoring the live sporting event for a break in action of the live sporting event; determining that there is a break in the action of the live sporting event; and providing at least one casino game during the break in action where the at least one casino game is selected based upon at least one characteristic of at least one wager made.

For example, in a betting exchange system method, a casino game is opened for a lay bettor when there is a time out called, but the lay bettor may get more and better games to play at times out, based upon how frequently the lay bettor is betting.

A machine learning betting system method of delivering casino games inside of a play by play wagering game, comprising: receiving data from a live sporting event upon which single play wagers can be played on plays inside of that live sporting event; receiving at least one wager from at least one user; monitoring the live sporting event for a break in action of the live sporting event; determining that there is a break in the action of the live sporting event; and using unsupervised machine learning to choose and then provide at least one casino game during the break in action where the at least one casino game is selected based upon at least one characteristic of at least one wager made.

For example, in a machine learning betting system method, a casino game is opened for a bettor when there is a time out called, the casino best game choice for each user is learned over time based upon how frequently bettor is betting and how active the user was using the casino game.

### EMBODIMENT 28A

### Live Event Recording Method and System

The embodiments are generally related to play by play wagering on live sporting events and recording plays of significance.

Embodiments include methods, systems and apparatuses for live event recordings in a real time single play wagering platform. One embodiment includes a system for recording video related to a play of significance in a live sporting event when a wager is placed on a play by play wagering platform, including a connection to a live sporting event upon which wagers can be placed on plays in a wagering game, a database storing wager history, a database storing video, a wager significance module that determines whether a wager on a play is significant based on the wager history and context of the play, and a video generated if the wager is determined to be significant.

Another embodiment includes a method of displaying recordings related plays in a live sporting event when a wager is placed on a play by play wagering platform, including executing on a processor the steps of displaying a wagering platform; displaying one or more live sporting events upon which a wagers can be placed play by play in real time; displaying one or more wager options; and displaying indicia that a video is made after selection of a wager.

Methods and systems for determining and providing automatic flags for what is classified as a “significant” bet. When the user makes a significant bet, a software application automatically records the play and may also record the user's reaction. The user does not have to provide an indication to record these clips.

### EMBODIMENT 28B

A system for providing video related to a play of significance in a live sporting event when a wager is placed on a play by play wagering platform, comprising a connection to a live sporting event upon which wagers can be placed on plays in a wagering game, a database storing wager history, a database storing video, a wager significance module that determines whether a wager on a play is significant based on the wager history and context of the play, and a video file generated if the wager is determined to be significant.

A betting exchange system for providing video related to a play of significance in a live sporting event when a laying wager is placed on a play by play wagering platform, comprising a connection to a live sporting event upon which laying wagers can be placed on plays in a wagering game, a database storing laying wager history, a database storing video, a wager significance module that determines whether a laying wager on a play is significant based on the laying wager history and context of the play, and a video file generated if the wager is determined to be significant.

For example, in a betting exchange system method, if the laying wages have increased from 5 dollars on average to 10 dollars on average for a user, this would be a 2× threshold change, which would be a rule to initiate generating a video file for the last laying wager won by the user.

A machine learning betting system for providing video related to a play of significance in a live sporting event when a wager is placed on a play by play wagering platform, comprising a connection to a live sporting event upon which wagers can be placed on plays in a wagering game, a database storing wager history, a database storing video, a wager significance module that used machine learning that determines whether a wager on a play is significant based on the wager history and context of the play, and a video file generated if the wager is determined to be significant.

For example, in a machine learning betting system method, if the wages for a user have increased from one level to a higher level, so a supervised machine learning system will increase bets to a user to learn whether the user will choose that increased bet or not, and when the user choses an increased bet level the system generates a video file for the last laying wager won by the user.

### EMBODIMENT 29A

### Method of Determining if a Single Play Bet is Too Risky

The embodiments are generally related to play by play wagering on live sporting events.

A system for wagering on outcomes of a live sporting event during the event wherein the odds users are given for a wager are generated based on historical data and then adjusted based on risk factors. These risk factors include lack of sufficient data to form an accurate odds assessment, a wide range of odds from similar plays, and overall monetary loss within a set time frame. Each factor is analyzed individually and then amalgamated into one adjustment factor which is then used to adjust the odds. In this way the system accounts for its own level of inaccuracy in calculating odds.

### EMBODIMENT 29B

A system for enhancing user experience of an in-play sports betting game, comprising: data received from a live sporting event upon which wagers can be placed on plays inside of that live sports event, a wagers database; at least one offered wager with odds; a primary risk module, and at least one secondary risk module, wherein the primary risk module adjusts the odds of the at least one wager based on an adjustment factor generated by at least one secondary risk module.

A betting exchange system for enhancing user experience of an in-play sports betting game, comprising: data received from a live sporting event upon which laying wagers can be placed on plays inside of that live sports event, a wagers database; at least one offered laying wager; a primary risk module, and at least one secondary risk module, wherein the primary risk module adjusts the laying wager offer of the at least one laying wager based on an adjustment factor generated by at least one secondary risk module.

For example, in a betting exchange system method, if there is a risk for low volume (primary risk module) and a current lack of profit for the house (secondary risk module) than the laying wager offer is offered at very conservative level, since the risks are high.

A machine learning betting system for enhancing user experience of an in-play sports betting game, comprising: data received from a live sporting event upon which wagers can be placed on plays inside of that live sports event, a wagers database; at least one offered wager with odds; a primary risk module, and at least one secondary risk module, wherein the primary risk module uses machine lanadjusts the odds of the at least one wager based on an adjustment factor generated by at least one secondary risk module.

For example, in a machine learning betting system method, if there is a risk for low volume (primary risk module) and a current lack of profit for the house (secondary risk module) than the laying wager offer is offered at very conservative level, since the risks are high.

### EMBODIMENT 30A

### Method of Rewarding Non-Dangerous Behavior

The embodiments are generally related to wagering on live sporting events, specifically increasing profitability and decreasing risk of an in-play betting system.

The embodiments include methods, systems, and apparatuses for incentivizing user interaction. One embodiment includes a system for incentivizing user interaction for in play sports betting, including a connection to a live event, a connection to a cloud, a connection to a mobile device, a wagering network connected through the cloud to a mobile device, a bettor classification module, a large bettor database, and an incentive module, where the wagering network creates odds for each play and provides one or more incentives to large bettors in the large bettor database to wager on a single play in a live sporting event.

In another embodiment, a method of providing wagers for a play in a live sporting event on a play by play wagering network, including executing on a processor the steps of displaying a wagering game; displaying one or more first odds for a wager on a single play in the live sporting event; displaying a notification that an incentive has been earned; and displaying a notification of one or more second odds for the wager on the single play in the live sporting event.

Improving the profitability of an in-play betting system by identifying high frequency and high wager amount users and promoting an increase in wager amount or frequency by offering incentives to increase a user's wager amount, if identified to be a high frequency bettor or wager frequency, if identified to be a high wager amount bettor.

### EMBODIMENT 30B

A system for incentivizing user interaction for in play sports betting, comprising: a connection to a live event, a connection to a cloud, a connection to a mobile device, a wagering network connected through the cloud to a mobile device, a bettor classification module, a large bettor database, and an incentive module, wherein the wagering network creates odds for each play and provides one or more incentives to large bettors in the large bettor database to wager on a single play in a live sporting event.

A betting exchange system for incentivizing user interaction for in play sports betting, comprising: a connection to a live event, a connection to a cloud, a connection to a mobile device, a wagering network connected through the cloud to a mobile device, a bettor classification module, a large bettor database, and an incentive module, wherein the wagering network creates laying odds for each play and provides one or more incentives to large laying bettors in the large bettor database to a layer wager on a single play in a live sporting event.

For example, in a betting exchange system method, laying odds could be 2:1 for one play outcome, but 10:1 for a second play out come, where the 10:1 odds carry an extra bonus of an added 10% is the bet is made in 10 seconds.

A machine learning betting system for incentivizing user interaction for in play sports betting, comprising: a connection to a live event, a connection to a cloud, a connection to a mobile device, a wagering network connected through the cloud to a mobile device, a bettor classification module, a large bettor database, and an incentive module, wherein the wagering network uses supervised machine learning to creates odds for each play and provides one or more incentives to large bettors in the large bettor database to wager on a single play in a live sporting event.

For example, in a machine learning betting system method, the supervised machine learning of the large bettor database determines that odds could be 2:1 for one play outcome, but 10:1 for a second play out come, where an unsupervised machine learning also determines from the large bettor database from the 10:1 odds carry an extra bonus of an added 10% is the bet is made in 10 seconds.

### EMBODIMENT 31A

Method of Displaying a Notification from a Betting Application Using AI that can Impact Normal Betting

The embodiments are generally related to play by play wagering on live sporting events

A system for wagering on outcomes of a live sporting event. The system includes an artificial intelligence-based process which will notify users when wagers that would be of interest to them are available. These notifications could be used to drive users to wagers where there is an imbalance wagers in order to reduce risk for the offeror of the wager.

### EMBODIMENT 31B

A method of providing wagers in a play by play wagering system, comprising: receiving data from a live sporting event upon which wagers can be placed on single plays inside of that live event, collecting preferred wager data from at least one wagering game account, detecting a loss risk based on a calculated imbalance of wagers placed on one possible outcome of an upcoming play, and sending one or more notifications based on preferred wagering data as a result of detecting an imbalance of wagers that at least meets a predetermined threshold.

A betting exchange system method of providing laying wagers in a play by play wagering system, comprising: receiving data from a live sporting event upon which laying wagers can be placed on single plays inside of that live event, collecting preferred layer wager data from at least one wagering game account, detecting a loss risk based on a calculated imbalance of laying wagers placed on one possible outcome of an upcoming play, and sending one or more notifications based on preferred wagering data as a result of detecting an imbalance of laying wagers that at least meets a predetermined threshold.

For example, in a betting exchange system method a laying wager is provided and risks are assessed about a possible outcome of an upcoming play, and sending a notification of a text message to a fellow user about the laying wager.

A machine learning betting system method of providing wagers in a play by play wagering system, comprising: receiving data from a live sporting event upon which wagers can be placed on single plays inside of that live event, collecting preferred wager data from at least one wagering game account, detecting a loss risk based on a calculated imbalance by using machine learning of wagers placed on one possible outcome of an upcoming play, and sending one or more notifications based on preferred wagering data as a result of detecting an imbalance of wagers that at least meets a predetermined threshold.

For example, in a machine learning betting system method, a wager is provided, and risks are assessed by using supervised machine learning about a possible outcome of an upcoming play, and sending a notification of a text message to a fellow user about the laying wager.

### EMBODIMENT 32A

### System for Replaying a Bet

The embodiments are generally related to play by play wagering on live sporting events and repeating specific wagers.

The embodiments can include one or more methods, systems, and apparatuses for replaying a bet in a wagering game. One embodiment includes a system for modifying a video file of a live sporting event to include details related to a wager placed on a play by play wagering system, including a wager database storing wagers made on a next play during the live sporting event, a recording database storing a video file of the live sporting event, and a wager review module, where the wager review module inserts details of a placed wager into the video file during the play upon which the wager was made.

Another embodiment includes a method of displaying wagers placed on a play by play wagering system, including executing on a processor the steps of: displaying a wagering platform; displaying one or more wagers for wagering on a single play of a live sporting event; and displaying a video of a past play from the live sporting event, the video including data from a wager made on the wagering platform.

A system for modifying video of a live sporting event to include details of a micro market wager. A wagering platform that offers wagers on micro markets inside of a sporting event can produce personalized content for each user around highlights of their wagering experience.

### EMBODIMENT 32B

A system for modifying a video file of a live sporting event to include details related to a wager placed on a play by play wagering system, comprising: a wager database storing wagers made on a next play during the live sporting event, a recording database storing a video file of the live sporting event, and a wager review module; wherein the wager review module inserts details of a placed wager into the video file during the play upon which the wager was made.

A betting exchange system for modifying a video file of a live sporting event to include details related to a laying wager placed on a play by play wagering system, comprising: a wager database storing laying wagers made on a next play during the live sporting event, a recording database storing a video file of the live sporting event, and a wager review module; wherein the wager review module inserts details of a placed layer wager into the video file during the play upon which the wager was made.

For example, in a betting exchange system method a video file of a play event gets embedded with a bettor's layer wagers of that play of a live sporting event.

A machine learning betting system method for modifying a video file of a live sporting event to include details related to a wager placed on a play by play wagering system, comprising: a wager database storing wagers made on a next play during the live sporting event, a recording database storing a video file of the live sporting event, and a wager review module; wherein the wager review module uses machine learning to inserts details of a placed wager into the video file during the play upon which the wager was made.

For example, in a machine learning betting system method, using a supervised machine learning to determine whether details or which details of a placed wager would be placed into a video file. The supervised machine learning analyzes past acceptance and use of insert wagers in video files to provide best details and which details to add to the video file.

### EMBODIMENT 33A

### Method for Replaying a Bet and Sharing

The embodiments are generally related to play by play wagering on live sporting events focused on individual players.

A method, system and apparatus for real time wagering, including replaying a wager or bet and sharing data across a wagering network. One embodiment can include a method of sharing a wager placed on a single play inside of a live sporting event on and video of the play on a wagering network via a social network, including receiving data from a live sporting event upon which wagers can be placed on single plays inside of that live event, and allowing at least one user to place a wager on a single play in the live event, and using video of the play upon which at least one user has placed a wager, where the user shares the wager and video with at least one other person on a social network.

Another embodiment includes a method of displaying wagers placed on a play by play wagering system, including executing on a processor the steps of displaying a wagering platform; displaying one or more wagers for wagering on a single play of a live sporting event; and displaying a notification that a video of a placed wager from the one or more displayed wagers has been shared.

A system for modifying video of a live sporting event to include details of a micro market wager. A wagering platform that offers wagers on micro markets inside of a sporting event can produce personalized content for each user around highlights of their wagering experience. The modified video can be shared with the user's contacts and the user can receive shared modified videos from their contacts.

### EMBODIMENT 33B

A method of sharing a wager placed on a single play inside of a live sporting event on and video of the play on a wagering network via a social network, comprising: receiving data from a live sporting event upon which wagers can be placed on single plays inside of that live event; allowing at least one user to place a wager on a single play in the live event; and using video of the play upon which at least one user has placed a wager, wherein the user shares the wager and video with at least one other person on a social network.

A betting exchange system method of sharing a wager placed on a single play inside of a live sporting event on and video of the play on a wagering network via a social network, comprising: receiving data from a live sporting event upon which laying wagers can be placed on single plays inside of that live event; allowing at least one user to place a laying wager on a single play in the live event; and using video of the play upon which at least one user has placed a laying wager, wherein the user shares the laying wager and video with at least one other person on a social network.

For example, in a betting exchange system method, after a user place a laying wager on a play while watching the video of the play, the user links to their social network and shares the laying wager and video to at least one person on the social network.

A machine learning betting system method of sharing a wager placed on a single play inside of a live sporting event on and video of the play on a wagering network via a social network, comprising: receiving data from a live sporting event upon which machine learning based wagers can be placed on single plays inside of that live event; allowing at least one user to place a wager on a single play in the live event; and using video of the play upon which at least one user has placed a wager, wherein the user shares the wager and video with at least one other person on a social network.

For example, in a machine learning betting system method, after a user places a wager from a supervised machine learning module on a play while watching the video of the play, the user links to their social network and shares the laying wager and video to at least one person on the social network.

### EMBODIMENT 34A

A Method of Displaying a Notification from a Betting Application Using AI that can Impact Normal Betting

The present embodiments are generally related to play by play wagering on live sporting events

A system for wagering on outcomes of a live sporting event. The system further includes using AI to balance itself between how much it will lose bets to encourage game players to bet more, ultimately to win more profit and gain a larger game player user base. This allows the system to reduce immediate profits in exchange for long term profits due to a larger market share.

### EMBODIMENT 34B

A method of providing wagers in a play by play wagering system, comprising: receiving data on a wagering system from a live sporting event upon which wagers can be placed on plays inside of that live event, calculating two or more different odds for at least one outcome of an upcoming play using two or more different algorithms, comparing context of the upcoming play to plays in a historical play database; retrieving odds of historical plays in the historical plays database that are similar in context to the upcoming play; estimating a level of user activity on at least one offered wager; and altering the wagering system based on the estimated level of user activity.

A betting exchange system method of providing laying wagers in a play by play wagering system, comprising: receiving data on a wagering system from a live sporting event upon which laying wagers can be placed on plays inside of that live event, calculating two or more different odds for at least one outcome of an upcoming play using two or more different algorithms, comparing context of the upcoming play to plays in a historical play database; retrieving odds of historical plays in the historical plays database that are similar in context to the upcoming play; estimating a level of user activity on at least one offered laying wager; and altering the wagering system based on the estimated level of user activity.

For example, in a betting exchange system method, if a first user activity is high, the betting exchange provides to that first user a conservative laying wager (average odds) based upon two different algorithms, but if second user has a small amount of activity the betting exchange provides an attractive and aggressive (high odds) laying wager based upon two algorithms to entice the small amount of activity of the second user to hopefully increase.

A machine learning betting system method of providing wagers in a play by play wagering system, comprising: receiving data on a wagering system from a live sporting event upon which wagers can be placed on plays inside of that live event, calculating two or more different odds for at least one outcome of an upcoming play using two or more different machine learning algorithms, comparing context of the upcoming play to plays in a historical play database; retrieving odds of historical plays in the historical plays database that are similar in context to the upcoming play; estimating a level of user activity on at least one offered wager; and altering the wagering system based on the estimated level of user activity.

For example, in a machine learning betting system method, if a first user activity is high, the betting exchange provides to that first user a conservative laying wager (average odds) based upon two different machine learning algorithms, but if second user has a small amount of activity the betting exchange provides an attractive and aggressive (high odds) laying wager based upon two machine learning algorithms to entice the small amount of activity of the second user to hopefully increase.

### EMBODIMENT 35A

### Marketplace of Odds

The present disclosure is generally related to play by play wagering on a live sporting event and how users can interact with multiple wagering networks.

A method, system, and apparatus to provide a marketplace for making and sharing odds, such as odds for real time wagers in a play by play wagering system. One embodiment includes a system for providing a marketplace of odds in a play by play wagering system, including: at least one wagering network that offers wagers on plays inside of a live sporting event, and a wagering marketplace that collects wagers from users and the at least one wagering network, allows the users to place wagers offered by the wagering network, allows the users to propose wagers, and allows the at least one wagering network and/or other users to accept user proposed bets.

In another exemplary embodiment, a method for displaying a marketplace of wagering odds on a single play of a live sporting event may be provided, including executing on a processor the steps of: displaying a wagering game; displaying one or more available wagers and odds from at least one wagering network, the one or more available wagers for a single play of a live sporting event; and displaying identifying data of a source of the wager with the one or more available wagers and odds.

A system for a user to choose from a number of odds offered by multiple wagering networks. The user can select one of the odds options. In an embodiment, the user has a GUI process (such as a scroll) to select the option of the odds. A user is provided two or more odds for a bet on one or more platforms. The user can select one of the odds options. In an additional embodiment, the user can receive one or more odds for a bet of one or more platforms and the user has the ability to respond to the one or more bets by offering an alternative odd for the bet. If a platform is accepted, then the bet will be concluded between the user and the platform.

### EMBODIMENT 35B

A system for providing a marketplace of odds in a play by play wagering system, comprising: at least one wagering network that offers wagers on plays inside of a live sporting event, and a wagering marketplace that collects wagers from users and the at least one wagering network, allows the users to place wagers offered by the wagering network, allows the users to propose wagers, and allows the at least one wagering network and/or other users to accept user proposed bets.

A betting exchange system for providing a marketplace of odds in a play by play wagering system, comprising: at least one wagering network that offers laying wagers on plays inside of a live sporting event, and a wagering marketplace that collects laying wagers from users and the at least one wagering network, allows the users to place laying wagers offered by the wagering network, allows the users to propose laying wagers, and allows the at least one wagering network and/or other users to accept user proposed bets.

For example, in a betting exchange system method, a laying bet is proposed in a betting exchange of a play, and a user proposes their own laying bet to other users.

A machine learning betting system for providing a marketplace of odds in a play by play wagering system, comprising: at least one wagering network that offers wagers using machine learning on plays inside of a live sporting event, and a wagering marketplace that collects wagers from users and the at least one wagering network, allows the users to place wagers offered by the wagering network, allows the users to propose wagers, and allows the at least one wagering network and/or other users to accept user proposed bets.

For example, in a machine learning betting system method, a laying bet is proposed in a betting exchange using unsupervised machine learning of a play, and a user proposes their own laying bet to other users.

### EMBODIMENT 36A

### Method of Offering a Marketplace of Odds for Wagering

The embodiments are generally related to play by play wagering on live sporting events focused on individual players.

Embodiments include methods and systems for making and facilitating peer to peer wagering. One embodiment includes a method of providing a marketplace of peer to peer wagers in a play by play wagering system, including receiving data from a live sporting event upon which wagers can be placed on single plays inside of that live event, receiving at least one proposed wager with settlement terms from at least one user, providing the proposed wager to at least one other user, and settling the wager.

Another embodiment includes a method for providing peer to peer wagering in a single play wagering system, including executing on a processor the steps of displaying a wagering game for wagering on single plays in a live event; displaying an option to create a wager on an upcoming play in the live event; displaying one or more terms associated with creating a wager on the upcoming play in the live event; and displaying a created wager on the upcoming play in the live event.

Another embodiment includes a system for providing peer to peer waging on a wagering network, including: a user database containing user identification for one or more users of a single play wagering game; an available wagers database containing one or more available wagers for upcoming single plays in a live event; an escrow database; a wagering module; and a settlement module, where the available wagers database is updated by one or more proposed wagers on one or more upcoming single plays in the live event and the one or more proposed wagers are created by the one or more users.

A system for peer-to-peer wagering on outcomes of a live sporting event. Users can select from a set of available wagers and set their own odds and terms, other users can then accept those odds and terms. The system may hold all involved user's money or credit in an escrow account until the actual outcome of the subject of the wager has been determined. Then the system handles the settlement of the wager, either directly or by communicating with a third party.

### EMBODIMENT 36B

A method of providing a marketplace of peer to peer wagers in a play by play wagering system, comprising: receiving data from a live sporting event upon which wagers can be placed on single plays inside of that live event; receiving at least one proposed wager with settlement terms from at least one user; providing the proposed wager to at least one other user; and settling the wager.

A betting exchange system method of providing a marketplace of peer to peer wagers in a play by play wagering system, comprising: receiving data from a live sporting event upon which laying wagers can be placed on single plays inside of that live event; receiving at least one proposed laying wager with settlement terms from at least one user; providing the proposed laying wager to at least one other user; and settling the laying wager.

For example, in a betting exchange system method, data is received from a live sporting event of a particular play and a laying wager is provided; receiving at least one proposed laying wager with settlement terms from at least one user; providing the proposed laying wager to at least one other user; and settling the laying wager.

A machine learning betting system method of providing a marketplace of peer to peer wagers in a play by play wagering system, comprising: receiving data from a live sporting event upon which a machine learning module creates wagers can be placed on single plays inside of that live event; receiving at least one proposed wager from a machine learning module with settlement terms from at least one user; providing the proposed wager to at least one other user; and settling the wager.

For example, in a machine learning betting system method, data is received from a live sporting event of a particular play and a wager is provided; receiving at least one proposed wager from a supervised machine learning module with settlement terms from at least one user; providing the proposed laying wager to at least one other user; and settling the laying wager. The settlement terms are chosen as the most likely settlement terms to succeed.

### EMBODIMENT 37A

### Fixed Wager Window Countdown

The present disclosure is generally related to play by play wagering on live sporting events

A system for wagering on outcomes of a live sporting event during a specific time window. The system estimates the duration of the time window based on historical data. The window then either closes at the end of the estimated duration or when the subject of the wager has occurred or is about to occur such that users cannot place wagers on an outcome that has already occurred. The estimated duration of the time window may be based on a statistical average of similar plays or may be determined by an artificial intelligence based algorithm or module.

### EMBODIMENT 37B

A system for calculating estimated time remaining to place a wager on a play on a play by play wagering system, comprising: a database storing wagers of a play by play wagering game during a live sporting event, the database further storing durations of one or more offers for wagers, a historical play database containing data about previous wager offers; and a wager offer module that estimates an amount of time remaining to place a wager on a next play based on the durations of one or more previous wager offers for similar plays.

A betting exchange system for calculating estimated time remaining to place a wager on a play on a play by play wagering system, comprising: a database storing laying wagers of a play by play wagering game during a live sporting event, the database further storing durations of one or more offers for laying wagers, a historical play database containing data about previous laying wager offers; and a wager offer module that estimates an amount of time remaining to place a laying wager on a next play based on the durations of one or more previous wager offers for similar plays.

For example, betting exchange system method calculates the estimated time remaining to place a wager on a play on a play-by-play wagering system, from stored laying wagers and durations of offers of plays of past during a live sporting event and a wager offer module estimates an amount of time remaining to place a laying wager on a next play based on the durations of one or more previous wager offers for similar plays.

A machine learning betting system for calculating estimated time remaining to place a wager on a play on a play by play wagering system, comprising: a database storing wagers of a play by play wagering game during a live sporting event, the database further storing durations of one or more offers for wagers, a historical play database containing data about previous wager offers; and a wager offer module that estimates, using machine learning, an amount of time remaining to place a wager on a next play based on the durations of one or more previous wager offers for similar plays.

For example, in a machine learning betting system method, calculates the estimated time remaining to place a wager on a play on a play by play wagering system, from stored wagers and durations of offers of plays of past during a live sporting event and a wager offer module estimates, using supervised machine learning an amount of time remaining to place a laying wager on a next play based on the durations of one or more previous wager offers for similar plays. The supervised machine learning optimizes the time for an offer based upon the best opportunity to increase volumes of bets.

### EMBODIMENT 38A

### AI Process to Identify User Behavior and Allow System to Trigger Specific Actions

The embodiments are generally related to wagering on live sporting events, specifically detecting automated wagers on a play by play wagering system.

Described is a method of detecting the use of automation to place wagers on a play by play wagering platform by a user's account by identifying correlations within the user's historical wager data exceeding a threshold indicating that automation is being used to place wagers using the user's account an invalidating wagers placed by the user's account.

### EMBODIMENT 38B

A system of identifying use of an automated wagering system on a play by play wagering system, comprising: a database storing wagers during a live sporting event, a placed wager on a single play of a live sporting event in the play by play wagering system; and an automation detection module that determines a presence of automation using two or more wager parameters of the placed wager with respect to one or more wagers in a historical wager database.

A betting exchange system of identifying use of an automated wagering system on a play by play wagering system, comprising: a database storing wagers during a live sporting event, a placed laying wager on a single play of a live sporting event in the play by play wagering system; and an automation detection module that determines a presence of automation using two or more wager parameters of the placed laying wager with respect to one or more laying wagers in a historical wager database.

For example, in a betting exchange system method, automation detection determines invalid laying wagers, so that when a laying wager is placed, it is checked for patterns of cheating or invalids amounts beyond limits or thresholds.

A machine learning betting system of identifying use of an automated wagering system on a play by play wagering system, comprising: a database storing wagers during a live sporting event, a placed wager on a single play of a live sporting event in the play by play wagering system; and an automation detection module using machine learning that determines a presence of automation using two or more wager parameters of the placed wager with respect to one or more wagers in a historical wager database.

For example, in a machine learning betting system method, automation detection determines invalid laying wagers, so that when a laying wager is placed, it is checked using supervised machine learning for patterns of cheating or invalids amounts beyond limits or thresholds.

### EMBODIMENT 39A

Method of Displaying in-Play Wagers

The embodiments are generally related to play by play wagering on a live sporting event, such as how a subset of wagers is selected to display to the user.

The embodiments include methods and systems for displaying in-play wagers. One embodiment includes a method of displaying information related to wagering on a single play in a live sporting event based on interaction with a live video feed, including receiving data from a live sporting event upon which wagers can be placed on plays inside of that live event, selecting a portion of the video feed of the live sporting event, and identifying elements of the live sporting event in a selected portion of the video feed of the live sporting event upon which real time wagers can be placed, where the available data from the live sporting event and available wagers are dependent upon the elements of the live sporting event that are being displayed in the selected portion of the video.

Another embodiment includes a method of displaying a wagering game that provides real time wagering on a live sporting event, including executing on a processor the steps of displaying a wagering game for real time betting on the live sporting event; displaying one or more selectable areas of the video of the live sporting event; and displaying available wagers of the wagering game based on a selected area of the video of the live sporting event, wherein the available wagers are dependent upon elements in the live sporting event that are displayed in the selected area of the video of the live sporting event.

A method of displaying wagers to a user viewing a live sporting event in which the wagers displayed to the user are dependent upon what element in the live sporting event are in the field of view being presented to the user. As the point of view of the user changes, either by user selection or based on the camera angle of the broadcast the user is viewing, the elements of the live sporting event, such as players or the ball, that are in the field of view are identified and the wagers available of those elements are displayed for the user to select.

### EMBODIMENT 39B

A method of displaying information related to wagering on a single play in a live sporting event based on interaction with a live video feed, comprising: receiving data from a live sporting event upon which wagers can be placed on plays inside of that live event; selecting a portion of the video feed of the live sporting event; and identifying elements of the live sporting event in a selected portion of the video feed of the live sporting event upon which real time wagers can be placed, wherein the available data from the live sporting event and available wagers are dependent upon the elements of the live sporting event that are being displayed in the selected portion of the video.

A betting exchange system method of displaying information related to wagering on a single play in a live sporting event based on interaction with a live video feed, comprising: receiving data from a live sporting event upon which laying wagers can be placed on plays inside of that live event; selecting a portion of the video feed of the live sporting event; and identifying elements of the live sporting event in a selected portion of the video feed of the live sporting event upon which real time laying wagers can be placed, wherein the available data from the live sporting event and available laying wagers are dependent upon the elements of the live sporting event that are being displayed in the selected portion of the video.

For example, in a betting exchange system method, while watching a live event video, a player is about to make a stolen base in baseball, a laying wager is determined and shown to the bettor.

A machine learning betting system method of displaying information related to wagering on a single play in a live sporting event based on interaction with a live video feed, comprising: receiving data from a live sporting event upon which wagers can be placed on plays inside of that live event; selecting a portion of the video feed of the live sporting event; and identifying elements of the live sporting event in a selected portion of the video feed of the live sporting event upon which real time wagers can be placed, wherein the available data from the live sporting event and available wagers are dependent upon the elements of the live sporting event calculated by a machine learning module that are being displayed in the selected portion of the video.

For example, in a machine learning betting system method, while watching a live event video, a player is about to make a stolen base in baseball, a supervised machine module calculates provides a wager to the bettor. The supervised machine learning module, that has analyzed thousands of plays in baseball recognizes that a stolen base situation is based upon at least throw by the pitcher to the baseman to keep the runner close to the base.

### EMBODIMENT 40A

### Voice Based Wagering

The embodiments are generally related to play-by-play wagering on live sporting events.

The embodiments include methods, systems, and apparatuses for wagering, such as voice based wagering. One embodiment includes a database storing wagers made in a play-by-play wagering game on actions in a live sporting event during the live sporting event; a natural language processor configured to receive user speech and store the user speech in a speech database; and an artificial intelligence module that analyzes the user speech in the speech database and delivers context-appropriate responses that provide context-appropriate information or wagers for wagers on plays inside of the live sporting event.

A device that provides for voice based wagering on live action events. The device has microphone capabilities that can actively or passively listen to voice input and interpret the input with respect to wagering opportunities or other requests. For example, users can speak into the microphone and navigate different “in-play” bets and select wagering options. In-play bets are the ability.

### EMBODIMENT 40B

A system for voice-controlled wagering on a play by play wagering system, comprising: a database storing wagers made in a play-by-play wagering game on actions in a live sporting event during the live sporting event; a natural language processor configured to receive user speech and store the user speech in a speech database; and an artificial intelligence module that analyzes the user speech in the speech database and delivers context-appropriate responses that provide context-appropriate information or wagers for wagers on plays inside of the live sporting event.

A betting exchange system for voice-controlled wagering on a play by play wagering system, comprising: a database storing wagers made in a play-by-play wagering game on actions in a live sporting event during the live sporting event; a natural language processor configured to receive user speech and store the user speech in a speech database; and an artificial intelligence module that analyzes the user speech in the speech database and delivers context-appropriate responses that provide context-appropriate information or laying wagers for laying wagers on plays inside of the live sporting event.

For example, in a betting exchange system method, a group of people are watching the game together and speech is heard and analyzed that shows excitement, such as cheers and phrase like “great catch”. The AI interprets this speech pattern as excitement and then enhances the next laying wager appropriately, adding riskier odds (more profitable for the house).

A machine learning betting system for voice-controlled wagering on a play by play wagering system, comprising: a database storing wagers made in a play-by-play wagering game on actions in a live sporting event during the live sporting event; a natural language processor configured to receive user speech and store the user speech in a speech database; and an machine learning module that analyzes the user speech in the speech database and delivers context-appropriate responses that provide context-appropriate information or wagers for wagers on plays inside of the live sporting event.

For example, in a machine learning betting system method, a group of people are watching the game together and speech is heard and analyzed that shows excitement, such as cheers and phrase like “great catch”. A supervised machine learning algorithm, after many trials interprets this speech pattern as excitement and this allows the machine learning betting system, to enhance the next laying wager appropriately, adding riskier odds (more profitable for the house).

### EMBODIMENT 41A

### Method of Displaying Sports News Related to a Placed Wager

The present embodiments are generally related to play-by-play wagering on live sporting events.

Methods and systems for displaying sports news related to an offered wager. In one embodiment, a method includes offering a wager on a wagering device that is communicatively coupled to a wagering network; collecting real-time sensor data from a live sporting event; extracting searchable data from the sensor data; searching for information on news from a database based on the searchable data from the sensor data or default search terms; and displaying the new information on an at least one mobile device that is communicatively coupled with the wagering network.

In another embodiment, a system for displaying sports news related to an offered wager may include a live sporting event upon which wagers are offered; one or more sensors that collect data from the live sporting event; at least one user device with a display; a wagering network communicatively coupled with the at least one user device; a database which contains news data related to the live event; and a news module which collects data from the one or more sensors and searches the database for news data related to aspects of the live event.

In another embodiment, a method for displaying relevant data from a database of news on a mobile device associated with a wagering network may be provided. The method may include, executing on a processor the steps of: displaying data associated with a live sporting event, displaying one or more available wagers associated with the live sporting event, displaying a placed wager, displaying an indication that sensor data associated with a subject of the placed wager is available, and displaying a list of news associated with the sensor data.

### EMBODIMENT 41B

A method for displaying sports news related to an offered wager, comprising; offering a wager on a wagering device that is communicatively coupled to a wagering network; collecting real-time sensor data from a live sporting event; extracting searchable data from the sensor data; searching for information on news from a database based on the searchable data from the sensor data or default search terms; and displaying the new information on an at least one mobile device that is communicatively coupled with the wagering network.

A betting exchange system method for displaying sports news related to an offered laying wager, comprising; offering a laying wager on a wagering device that is communicatively coupled to a wagering network; collecting real-time sensor data from a live sporting event; extracting searchable data from the sensor data; searching for information on news from a database based on the searchable data from the sensor data or default search terms; and displaying the new information on an at least one mobile device that is communicatively coupled with the wagering network.

For example, in a betting exchange system method, a laying wager of say 2:1 is offered on the pitcher for the next pitch, and the betting exchange system finds a news article on the pitcher that last week the pitcher pulled and arm muscle. Because of this news information, the laying wager user may bet more conservatively (take lower risk).

A Machine learning betting system method for displaying sports news related to an offered wager, comprising; offering a wager on a wagering device that is communicatively coupled to a wagering network; collecting real-time sensor data from a live sporting event; extracting searchable data from the sensor data; using supervised machine learning, searching for information on news from a database based on the searchable data from the sensor data or default search terms; and displaying the new information on an at least one mobile device that is communicatively coupled with the wagering network.

For example, in a machine learning betting system method, a laying wager of say 2:1 is offered on the pitcher for the next pitch, and the machine learning betting system finds a news article on the pitcher that last week the pitcher pulled and arm muscle. Because of this news information, the supervised machine learning system will appropriately use this risk to adjust odds before providing the wagers to the users, since its likely bettors will be more conservative, take lower risk because of an injury.

### EMBODIMENT 42A

### Method for Performing Analytics on a User'S Wagering History

The present embodiments are generally related to play-by-play wagering on live sporting events.

Methods and systems for performing analytics on the wagering history of a user or group of users may be shown and described. In one embodiment, a method for performing analytics on wagering history of a user and a cohort on a wagering network can include grouping users into cohorts; storing a wagering history of at least one user and at least one cohort in at least one database; analyzing the wagering history of a user in the database; analyzing the wagering history of a cohort in the database; determining a historical wagering success rate of the user and the cohort; and displaying the success rate of the user and the cohort for a selected wager market on an application or device.

In another embodiment, a system for performing analytics on wagering history of a user and a cohort on a wagering network may be provided. The system can include a base wagering module configured to initiate at least one of a cohort module, a user analytics module, and a cohort analytics module; the cohort module configured to group users into a cohort; the user analytics module configured to analyze and display wagering history of a user; the cohort analytics module configured to analyze and display wagering history of a cohort; a user database configured to store at least one wagering history and cohort number of the user; a cohort database configured to store at least one cohort number and cohort requirement; and a device or application configured to display a notification.

The present disclosure provides a method for performing analytics on a user's wagering history and performing analytics on users with similar characteristics of the user and displaying the percentages on a wagering application to inform the user of their success rate of wagering on similar wager markets as well as the success rate for users with similar characteristics of the user. The method groups users with similar characteristics into various cohorts, allowing the system to analyze the user's wagering history and users that are similar to the user and inform the user of the user's success rate and the cohort that the user is placed in.

### EMBODIMENT 42B

A method for performing analytics on wagering history of a user and a cohort on a wagering network, comprising: grouping users into cohorts; storing a wagering history of at least one user and at least one cohort in at least one database; analyzing the wagering history of a user in the database; analyzing the wagering history of a cohort in the database; determining a historical wagering success rate of the user and the cohort; and displaying the success rate of the user and the cohort for a selected wager market on an application or device.

A betting exchange system method for performing analytics on wagering history of a user and a cohort on a wagering network, comprising: grouping users into cohorts; storing a laying wagering history of at least one user and at least one cohort in at least one database; analyzing the laying wagering history of a user in the database; analyzing the laying wagering history of a cohort in the database; determining a historical laying wagering success rate of the user and the cohort; and displaying the success rate of the user and the cohort for a selected wager market on an application or device.

For example, in a betting exchange system method, if a first user has a laying wagerer history against a randomly chosen cohort shows, for the next play, a 25% better success rate in winning, this first user may be more apt to bet on the next play.

A machine learning betting system method for performing analytics on wagering history of a user and a cohort on a wagering network, comprising: grouping users into cohorts; storing a wagering history of at least one user and at least one cohort in at least one database; analyzing, using machine learning, the wagering history of a user in the database; analyzing the wagering history of a cohort in the database; determining a historical wagering success rate of the user and the cohort; and displaying the success rate of the user and the cohort for a selected wager market on an application or device.

For example, in a machine learning betting system method, for a first user, unsupervised machine learning on the first users wagerer history shows a positive success pattern against a randomly chosen cohort (thee unsupervised machine learning determines, from all the first users plays, where the positive patterns are against the cohort group. If the pattern is positive for the next play, the positive pattern ins shown to the first user. The first user may be more apt to bet on the next play.

### EMBODIMENT 43A

### Time Stamping Process to Determine User Behaviors on A Wagering Platform

The embodiments are generally related to play by play wagering on live sporting events.

### Summary

A method and system for marking activity on a sports betting system. In one embodiment, the system can include a live sporting event; one or more mobile devices; a wagering network communicatively connected to the one or more mobile devices; a data collection module on the wagering network; a correlation module on the wagering network; and a cohort module on the wagering network, wherein timestamp data associated with actions performed on the one or more mobile devices are collected by the data collection module and transmitted to the wagering system, the correlation module performs correlations on the timestamps, and a cohort behavior is determined with respect to actions performed on at least one of the one or more mobile devices by the cohort module.

In another embodiment, a method of providing notifications on a wagering system may be provided. The method can include collecting timestamped user activity data on an interface for a wagering network; transmitting the collected timestamped user activity data to a cloud database associated with the wagering network; correlating the collected timestamped user activity data; determining cohort behavior based on the correlated data; and transmitting a notification to the interface, wherein the notification is transmitted automatically and contains information associated with the determined cohort behavior.

The present disclosure provides a system to time stamp user interactions on a wagering platform or application to determine user behaviors allowing the platform or application to group the users in specific cohorts or groups related to their behaviors on the platform or application. Also, the system provides an AI process that allows the use of a plurality of time-stamped parameters that are used to determine the user behaviors and interactions with the platform or application.

### EMBODIMENT 43B

A system for marking activity on a sports betting system, comprising: a live sporting event; one or more mobile devices; a wagering network communicatively connected to the one or more mobile devices; a data collection module on the wagering network; a correlation module on the wagering network; and a cohort module on the wagering network, wherein timestamp data associated with actions performed on the one or more mobile devices are collected by the data collection module and transmitted to the wagering system, the correlation module performs correlations on the timestamps, and a cohort behavior is determined with respect to actions performed on at least one of the one or more mobile devices by the cohort module.

A betting exchange system for marking activity on a sports betting system, comprising: a live sporting event; one or more mobile devices; a wagering network communicatively connected to the one or more mobile devices to provide laying wagers; a data collection module on the wagering network; a correlation module on the wagering network; and a cohort module on the wagering network, wherein timestamp data associated with actions performed on the one or more mobile devices are collected by the data collection module and transmitted to the wagering system, the correlation module performs correlations on the timestamps, and a cohort behavior is determined with respect to actions performed on at least one of the one or more mobile devices by the cohort module.

For example, in a betting exchange system method, if the betting exchange system finds a high correlation to a user accepting a laying wager within in certain time window of the laying wager offer, say 5 seconds, and the users has not yet accepted the laying wager, an incentive (small gift or prize) may be offered to further incent the laying wager to be accepted.

A machine learning betting system for marking activity on a sports betting system, comprising: a live sporting event; one or more mobile devices; a wagering network communicatively connected to the one or more mobile devices; a data collection module on the wagering network; a correlation module on the wagering network; and a cohort module on the wagering network, wherein timestamp data associated with actions performed on the one or more mobile devices are collected by the data collection module and transmitted to the wagering system, the correlation module performs correlations on the timestamps, and a cohort behavior is determined with respect to actions performed on at least one of the one or more mobile devices by the cohort module, whereby a supervised machine learning algorithm determines when and if and timing and type of a gift to be offered to incent the wager being accepted.

For example, in a machine learning betting system method, if the machine learning betting system finds a high correlation to a user accepting a laying wager within in certain time window of the laying wager offer, say 5 seconds, and the users has not yet accepted the laying wager, a supervised machine learning algorithm determines when and if and timing and type of a gift to be offered to incent the wager being accepted, and an incentive (small gift or prize) may be offered to further incent the laying wager to be accepted.

### EMBODIMENT 44A

### Lineup Specific Odds Manipulation

The present embodiments are related to play-by-play wagering on live sporting events.

Methods and systems for wagering. In one embodiment, a method of adjusting odds based on a lineup for a play-by-play wagering network may include collecting real-time sensor data from a live sporting event upon which play-by-play wagers may be placed; identifying initial historical play data; generating odds on at least one potential future state of a current play in the live sporting event; receiving data related to one or more next players scheduled to participate in the live sporting event; identifying similar historical plays that are similar to the current play based on the next player data; and calculating adjusted odds for the current play based on the similar historical plays, the next player data, and the real-time sensor data.

In another embodiment, a system for adjusting odds based on a lineup for a play-by-play wagering network may be provided. The system can include one or more sensors that collect real-time sensor data from a live sporting event upon which play by play wagers can be placed; a historical plays database which contains data on historical plays; an odds calculation module which generates odds for at least one potential future state of a current play in the live sporting event; a line-up database which contains data related to one or more next players scheduled to participate in the live sporting event; and an odds adjustment module which identifies the similar historical plays that are similar to the current play based on next player data, and calculates adjusted odds for the current play based on the similar historical plays, the next player data, and the real-time sensor data.

A method of AI adjusting odds based on the context of the lineup in baseball or cricket. Specific examples include a batter likely to be pitched around because of who is up next and when a reliever is approaching his third batter faced (the minimum before he can be replaced).

### EMBODIMENT 44B

A method of adjusting odds based on a lineup for a play-by-play wagering network, comprising: collecting real-time sensor data from a live sporting event upon which play-by-play wagers may be placed; identifying initial historical play data; generating odds on at least one potential future state of a current play in the live sporting event; receiving data related to one or more next players scheduled to participate in the live sporting event; identifying similar historical plays that are similar to the current play based on the next player data; and calculating adjusted odds for the current play based on the similar historical plays, the next player data, and the real-time sensor data.

A betting exchange system method of adjusting odds based on a lineup for a play-by-play wagering network, comprising: collecting real-time sensor data from a live sporting event upon which play-by-play laying wagers may be placed; identifying initial historical play data; generating laying bet odds on at least one potential future state of a current play in the live sporting event; receiving data related to one or more next players scheduled to participate in the live sporting event; identifying similar historical plays that are similar to the current play based on the next player data; and calculating adjusted laying bets odds for the current play based on the similar historical plays, the next player data, and the real-time sensor data.

For example, the betting exchange system method calculates and adjusts laying bets odds for the current play based on the similar historical plays, the next player data, and the real-time sensor data, where if an injury of a star grand slam player in the lineup may means there is a possibility of less of a success for a particular grand slam play results, the odds for a grand slam are calculated based upon the injury and a more conservative lay bet is provided.

A machine learning system method of adjusting odds based on a lineup for a play-by-play wagering network, comprising: collecting real-time sensor data from a live sporting event upon which play-by-play wagers may be placed; identifying initial historical play data; generating odds on at least one potential future state of a current play in the live sporting event; receiving data related to one or more next players scheduled to participate in the live sporting event; identifying similar historical plays that are similar to the current play based on the next player data; and a machine learning modules calculates and adjusted odds for the current play based on the similar historical plays, the next player data, and the real-time sensor data.

For example, the machine learning betting system calculates and adjusts bets odds for the current play based on the similar historical plays, the next player data, and the real-time sensor data, where if an injury of a star grand slam player in the lineup may means there is a possibility of less of a success for a particular grand slam play results, the odds for a grand slam are calculated using a supervised machine learning module, where the supervised machine learning module provides, based upon the injury data, a more conservative lay bet is provided.

### EMBODIMENT 45A

### Method of Constantly Displaying the Progress of a Game Goal to Increase User Engagement

The embodiments are generally related to play-by-play wagering on live sporting events.

A method and system for implementing and displaying progress of a game goal. In one embodiment, a method for constantly displaying the progress of a game goal in a progressive game, can include receiving data from a live sporting event upon which single play wagers can be placed on plays inside of the live sporting event; receiving at least one wager from at least one user on a device communicatively coupled with a wagering network configured to host play by play wagering on the live sporting event; identifying whether the at least one wager resulted in a loss for the at least one user; determining how much the loss contributes to a net loss associated with the at least one user; and increasing the net loss based on a predetermined amount associated with the loss by the at least one user.

In another embodiment, a system for constantly displaying the progress of a game goal in a progressive game can be provided. The system can include a live sporting event upon which single play wagers can be placed on plays inside of the live sporting event at least one user device; at least one user device with a display; a wagering network communicatively coupled with the at least one user device; a progressive offer module, wherein the progressive offer module stores the wager results from the at least one user device in a progressive database; and a betting accrue module which receives wager results from the progressive database, and increases a net loss associated with the at least one user by a predetermined amount associated with the wager result.

A system for a progressive game that allows users of a wagering app to recoup losses in the form of an individual progressive jackpot that will increase user engagement. The progressive jackpot contributions are displayed on the wagering app to increase user engagement. Each player who has lost money or points will have some percentage to go into an individual jackpot. Once the player or user has passed a predetermined threshold, the jackpot will be won by the individual player allowing the user or player to recoup some of their losses.

### EMBODIMENT 45B

A method for constantly displaying the progress of a game goal in a progressive game, comprising: receiving data from a live sporting event upon which single play wagers can be placed on plays inside of the live sporting event; receiving at least one wager from at least one user on a device communicatively coupled with a wagering network configured to host play by play wagering on the live sporting event; identifying whether the at least one wager resulted in a loss for the at least one user; determining how much the loss contributes to a net loss associated with the at least one user; and increasing the net loss based on a predetermined amount associated with the loss by the at least one user.

A betting exchange system method for constantly displaying the progress of a game goal in a progressive game, comprising: receiving data from a live sporting event upon which single play laying wagers can be placed on plays inside of the live sporting event; receiving at least one wager from at least one user on a device communicatively coupled with a wagering network configured to host play by play laying wagering on the live sporting event; identifying whether the at least one laying wager resulted in a loss for the at least one user; determining how much the loss contributes to a net loss associated with the at least one user; and increasing the net loss based on a predetermined amount associated with the loss by the at least one user.

For example, in a betting exchange system method, if a user has lost enough laying wagers based upon a threshold, say 10 losses in a row of at least 100 dollars, that user is entered into a jackpot prize group.

A machine learning betting system method for constantly displaying the progress of a game goal in a progressive game, comprising: receiving data from a live sporting event upon which single play wagers can be placed on plays inside of the live sporting event; receiving at least one wager from at least one user on a device communicatively coupled with a wagering network configured to host play by play wagering on the live sporting event; identifying whether the at least one wager resulted in a loss for the at least one user; determining, by machine learning how much the loss contributes to a net loss associated with the at least one user; and increasing the net loss based on a predetermined amount associated with the loss by the at least one user.

For example, in a machine learning betting system method, if a user has lost enough wagers based upon a unsupervised machine learning module, say the unsupervised machine learning module shows that 10 losses in a row of at least 100 dollars, is a level that would incent the user to still bet, if they are entered into a jackpot prize group, then the jackpot is presented to that user.

### EMBODIMENT 46A

### At-Bat/Per Drive Wagering

The embodiments are generally related to play-by-play wagering on live sporting events.

Methods and systems for wagering. In one embodiment, a method for offering play count wagers in a play-by-play sports betting network may be provided. The method can include collecting real-time sensor data from a live sporting event; extracting historical data similar to the real-time sensor data from a historical database; calculating the probability of at least one sub-event occurring during at least one play in the live event based off the historical data and real-time sensor data; and outputting a wager on a wagering device that is communicatively coupled to a wagering network, wherein the wager outputted on the wagering device is a wager on whether one or more of the at least one sub-events will occur during the at least one play in the live event.

In another embodiment a system for offering play count wagers in a play-by-play sports betting network can include a live sporting event upon which play-by-play wagers can be placed; one or more sensors that collect data from the live event; at least one wagering device; a wagering network communicatively coupled with the at least one wagering device; a historical plays database which contains play data for the type of sport being played in the live sporting event; and a next plays wager module which calculates the probability of at least one sub-event occurring during at least one play in the live event based off historical play data and real-time sensor data; where a wager can be placed on the at least one wagering device communicatively coupled with the wagering network on whether one or more of the at least one sub-events will occur during the at least one play in the live event.

A micro market focused on which batters will bat in an inning, for example, a very high price on the ninth man due up in an inning, but a low price for the fourth batter. This approach is a variation of betting on the number of plays in a football drive.

### EMBODIMENT 46B

A method for offering play count wagers in a play-by-play sports betting network, comprising: collecting real-time sensor data from a live sporting event; extracting historical data similar to the real-time sensor data from a historical database; calculating the probability of at least one sub-event occurring during at least one play in the live event based off the historical data and real-time sensor data; and outputting a wager on a wagering device that is communicatively coupled to a wagering network, wherein the wager outputted on the wagering device is a wager on whether one or more of the at least one sub-events will occur during the at least one play in the live event.

A betting exchange system method for offering play count laying wagers in a play-by-play sports betting network, comprising: collecting real-time sensor data from a live sporting event; extracting historical data similar to the real-time sensor data from a historical database; calculating the probability of at least one sub-event occurring during at least one play in the live event based off the historical data and real-time sensor data; and outputting a laying wager on a wagering device that is communicatively coupled to a wagering network, wherein the laying wager outputted on the wagering device is a laying wager on whether one or more of the at least one sub-events will occur during the at least one play in the live event.

For example, in a betting exchange system method, if a laying bet is created by the betting exchange system for a first play based upon sensors of who is on the field for the offense, the laying bet is say a pass in football by the quarterback of the offense, and a second event is added to the same laying wager of an interception by a defense player.

A machine learning betting system method for offering play count wagers in a play-by-play sports betting network, comprising: collecting real-time sensor data from a live sporting event; extracting historical data similar to the real-time sensor data from a historical database; using machine learning to calculate the probability of at least one sub-event occurring during at least one play in the live event based off the historical data and real-time sensor data; and outputting a wager on a wagering device that is communicatively coupled to a wagering network, wherein the wager outputted on the wagering device is a wager on whether one or more of the at least one sub-events will occur during the at least one play in the live event.

For example, in a machine learning betting system method, if a bet is created by using a supervised machine learning system for various possible parlays, for a first play based upon using sensors data, and the supervised machine learning calculates that bets would be made profitably, for the field for the offense, the bet is say a pass in football by the quarterback of the offense, and a second event is added to the same bet of an interception by a defense player.

### EMBODIMENT 47A

Method of Notifying a User about Placing an Uncommon Bet

The embodiments are generally related to play by play wagering on live sporting events.

Methods and systems for detecting uncommon transactions in a wagering system. In one embodiment, a method can include receiving a wager on an action in a live sporting event from a user; associating the wager on the action in the live sporting event with a user ID; storing the wager on the action in the live sporting event in a wager database; comparing the wager on the action in the live sporting event to a plurality of previous wagers in a historical wager database; determining if the wager on the action in the live sporting event is uncommon based on the comparison of the wager on the action in the live sporting event to the plurality of previous wagers in the historical wager database; and automatically sending an alert if the wager on the action in the live sporting event is determined to be uncommon.

In another embodiment, a system for detecting an uncommon wager in a wagering game may be provided. The system can include a live sporting event; a wagering game provided on a wagering device; one or more wagers available on the wagering game on actions in the live sporting event; a wager made in the wagering game on an action in the live sporting event by a user; a wager database that stores the wager made in the wagering game on the action in the live sporting event; a historical wager database that stores previous wagers associated with at least the user; a bet check module that compares the wager made in the wagering game on the action in the live sporting event to one or more wagers in the historical wager database and determines if the wager is an uncommon wager; and an alert that is automatically generated and transmitted if the wager is determined to be an uncommon wager.

The application determines what the typical wager is. The application flags a new wager is uncommon. The application notifies the user of the uncommon wager.

### EMBODIMENT 47B

A method for detecting uncommon transactions in a wagering system, comprising: receiving a wager on an action in a live sporting event from a user; associating the wager on the action in the live sporting event with a user ID; storing the wager on the action in the live sporting event in a wager database; comparing the wager on the action in the live sporting event to a plurality of previous wagers in a historical wager database; determining if the wager on the action in the live sporting event is uncommon based on the comparison of the wager on the action in the live sporting event to the plurality of previous wagers in the historical wager database; and automatically sending an alert if the wager on the action in the live sporting event is determined to be uncommon.

A betting exchange system method for detecting uncommon transactions in a wagering system, comprising: receiving a laying wager on an action in a live sporting event from a user; associating the laying wager on the action in the live sporting event with a user ID; storing the laying wager on the action in the live sporting event in a wager database; comparing the laying wager on the action in the live sporting event to a plurality of previous laying wagers in a historical wager database; determining if the laying wager on the action in the live sporting event is uncommon based on the comparison of the laying wager on the action in the live sporting event to the plurality of previous laying wagers in the historical wager database; and automatically sending an alert if the laying wager on the action in the live sporting event is determined to be uncommon.

For example, in a betting exchange system method, a laying wager for a user ID is checked against history for that user, and it is found that two successive laying wagers were made for 10× greater than usual, this creates an alert to the betting exchange system for an unusual bet. The betting exchange could create the alert based upon examples such as (1) a threshold multiple, e.g 10×, (2) a large volume of small winning bets.

A machine learning betting system method for detecting uncommon transactions in a wagering system, comprising: receiving a wager on an action in a live sporting event from a user; associating the wager on the action in the live sporting event with a user ID; storing the wager on the action in the live sporting event in a wager database; comparing the wager on the action in the live sporting event to a plurality of previous wagers in a historical wager database; determining by machine learning if the wager on the action in the live sporting event is uncommon based on the comparison of the wager on the action in the live sporting event to the plurality of previous wagers in the historical wager database; and automatically sending an alert if the wager on the action in the live sporting event is determined to be uncommon.

For example, in a machine learning betting system method, a wager for a user ID is checked using unsupervised machine learning against history for that user, and it is found that two successive wagers were made for 10× greater than usual, and the unsupervised machine learning identified this users behavior as a non-normal bet, and this creates an alert to the machine learning system for an unusual bet. The machine learning system could create the alert based upon many non-normal best, examples such as (1) a threshold multiple, e.g 10×, (2) a large volume of small winning bets.

### EMBODIMENT 48A

### Video Analysis for Visual Indicator of Market Suspension

The embodiments are generally related to play by play wagering on live sporting events.

A method and system for controlling and enabling access to a wagering network and available wagers. In one embodiment, a method of suspending a wager market in a play-by-play sports betting application is provided. The method can include providing a wager market in a sport betting application; receiving and storing one or more wagers in a database, the wagers having been placed on an action in a live sporting event; receiving and storing data collected by at least one sensor associated with the live sporting event; interpreting the data collected by the at least one sensor to determine a next play will begin; and suspending the wager market from receiving wagers based on the interpreted data collected by the at least one sensor.

In another embodiment, a system for controlling availability of wagering on a sports betting application may be provided. The system can include a live sporting event; one or more sensors configured to collect and transmit data associated with the live sporting event; a sports betting application configured to receive and place wagers; a market suspension module configured to control the availability of the sports betting application to receive and place wagers; and one or more market suspension indicators based on the data collected by the one or more sensors, where the determination that at least one market suspension indicator has been detected prompts the market suspension module to suspend the receipt and placement of wagers in the sports betting application.

A system for suspending a micro-market through a visual indicator, such as the offense breaking the huddle or the referee removing his hand from the ball after the spot when the offensive line is at the line of scrimmage waiting to run the play.

### EMBODIMENT 48B

A method of suspending a wager market in a play-by-play sports betting application, comprising: providing a wager market in a sport betting application; receiving and storing one or more wagers in a database, the wagers having been placed on an action in a live sporting event; receiving and storing data collected by at least one sensor associated with the live sporting event; interpreting the data collected by the at least one sensor to determine a next play will begin; and suspending the wager market from receiving wagers based on the interpreted data collected by the at least one sensor.

A betting exchange system method of suspending a laying wager market in a play-by-play sports betting application, comprising: providing a laying wager market in a sport betting application; receiving and storing one or more laying wagers in a database, the laying wagers having been placed on an action in a live sporting event; receiving and storing data collected by at least one sensor associated with the live sporting event; interpreting the data collected by the at least one sensor to determine a next play will begin; and suspending the laying wager market from receiving laying wagers based on the interpreted data collected by the at least one sensor.

For example, in a betting exchange system method, if an optical sensors of the pitcher mound (rubber) and the pitcher foot are used to suspend the market (no more lay bets) are interpreted by the betting exchange system as the market is open, that is pitcher foot is on the ground, but when a pitchers foot is lifted, the market is suspended and no more lay betting is allowed.

A machine learning betting system method of suspending a wager market in a play-by-play sports betting application, comprising: providing a wager market in a sport betting application; receiving and storing one or more wagers in a database, the wagers having been placed on an action in a live sporting event; receiving and storing data collected by at least one sensor associated with the live sporting event; using machine learning to interpret the data collected by the at least one sensor to determine a next play will begin; and suspending the wager market from receiving wagers based on the interpreted data collected by the at least one sensor.

For example, in a machine learning betting system method, if an optical sensor of the pitcher mound (rubber) and the pitcher foot are used to suspend the market (no more lay bets) are interpreted by the betting exchange system as the market is open, that is pitcher foot is on the ground, but when a pitchers foot is changed by an angle where the supervised machine learning finds a correlation to the next second the pitcher will lift their foot, the market is suspended and no more betting is allowed.

### EMBODIMENT 49A

Pool Users with Progressive Jackpot

The present embodiments are generally related to play-by-play wagering on live sporting events.

Methods, systems, and apparatuses for pooling users on a wagering network may be shown and described. One embodiment provides a method of offering a group jackpot in a play-by-play sports betting network, including: storing play-by-play wagers made during a live sporting event on a sports betting network; identifying users based on wagering devices used by the users to make the play-by-play wagers on the sports betting network; storing user identification information of the identified users in a group database; grouping at least two users together into a betting group on the sports betting network; determining wager wins and losses for the betting group; adding a portion of wager losses for each user in the betting group to the group jackpot; dynamically determining an amount of the group jackpot; and awarding the group jackpot or a portion of the group jackpot to one or more of the users in the betting group.

In another embodiment, a system for offering a group jackpot in a play-by-play sports betting network, includes a live sporting event upon which play-by-play wagers can be placed on a sports betting network; two or more user devices for placing wagers, the two or more user devices associated with two or more individual users and the sports betting network communicatively coupled with the two or more user devices; a group join module which assigns two or more users to a betting group and assigns each group a group ID; a group wager module which determines wager wins and losses and adds some or all of the wager losses to the group jackpot; and a group jackpot module that dynamically determines the size of the group jackpot and awards the group jackpot or a portion of the group jackpot to one or more users in the betting group.

The present disclosure provides a method of offering a pooled progressive jackpot in a play-by-play wagering network in which groups of users have a portion of their losses assigned to a progressive jackpot. One or more plays in a live sporting event have the progressive jackpot assigned to one or more wagers. When a user wins the wager that the progressive jackpot has been randomly assigned to, and the wager and user meet the eligibility requirements, the progressive jackpot is awarded.

### EMBODIMENT 49B

A method of offering a group jackpot in a play-by-play sports betting network, comprising: storing play-by-play wagers made during a live sporting event on a sports betting network; identifying users based on wagering devices used by the users to make the play-by-play wagers on the sports betting network; storing user identification information of the identified users in a group database; grouping at least two users together into a betting group on the sports betting network; determining wager wins and losses for the betting group; adding a portion of wager losses for each user in the betting group to the group jackpot; dynamically determining an amount of the group jackpot; and awarding the group jackpot or a portion of the group jackpot to one or more of the users in the betting group.

A betting exchange system method of offering a group jackpot in a play-by-play sports betting network, comprising: storing play-by-play wagers made during a live sporting event on a sports betting network; identifying users based on wagering devices used by the users to make the play-by-play wagers on the sports betting network; storing user identification information of the identified users in a group database; grouping at least two users together into a betting group on the sports betting network; determining laying wager wins and losses for the betting group; adding a portion of laying wager losses for each user in the betting group to the group jackpot; dynamically determining an amount of the group jackpot; and awarding the group jackpot or a portion of the group jackpot to one or more of the users in the betting group.

For example, in a betting exchange system method, grouping a group of users with similar losses on lay wagers over a series of the last 10 plays, and dynamically determining an amount of the group jackpot; and awarding the group jackpot or a portion of the group jackpot to one or more of the users in the betting group.

A machine learning betting system method of offering a group jackpot in a play-by-play sports betting network, comprising: storing play-by-play wagers made during a live sporting event on a sports betting network; identifying users based on wagering devices used by the users to make the play-by-play wagers on the sports betting network; storing user identification information of the identified users in a group database; grouping at least two users together into a betting group on the sports betting network; determining wager wins and losses for the betting group; adding a portion of wager losses for each user in the betting group to the group jackpot; dynamically determining, using a machine learning module, an amount of the group jackpot; and awarding the group jackpot or a portion of the group jackpot to one or more of the users in the betting group.

For example, in a machine learning betting system method, grouping a group of users with similar losses on wagers over a series of the last ten plays, and dynamically determining, using a supervised machine learning module, an amount of the group jackpot, for instance all users who have loss more than 100 dollars in ten wagers; and then awarding a group jackpot or a portion of the group jackpot, determined by the supervised machine learning to be equal to 10% of their combined losses. to one or more of the users in the betting group.

### EMBODIMENT 50A

### Parallel Streaming

The embodiments are generally related to play-by-play wagering on live sporting events.

Methods and systems for compensating for network latency in a networked game. One embodiment may include a method for compensating for network latency for a sports betting game. The method may include providing a sports betting game on a network, the sports betting game associated with at least a live sporting event; storing wager data in a database associated with the sports betting game; sending a first stream of data to a mobile device, the first stream of data containing wager data with the mobile device; and sending a second stream of data to the mobile device, the second stream of data containing media data.

Another embodiment may include a system for synchronizing display of multiple data streams on a device. The system may include a device configured to display at least wager data and media data; a wagering game accessible via the device; a first data stream transmitted to the device, the first data stream comprising media data associated with a live sporting event; a second data stream transmitted to the device, the second data stream comprising wager data associated with the live sporting event; and an integration module that delays display of the second data stream on the device until a time when the first data stream is displayed on the device.

A system for wagering and viewing the event on the same device while receiving the wagering data on a separate data feed from the video feed. Separate feeds would allow the wagering markets to close in more real-time while not relying on the video latency.

### EMBODIMENT 50B

A method for compensating for network latency for a sports betting game, comprising: providing a sports betting game on a network, the sports betting game associated with at least a live sporting event; storing wager data in a database associated with the sports betting game; sending a first stream of data to a mobile device, the first stream of data containing wager data with the mobile device; and sending a second stream of data to the mobile device, the second stream of data containing media data.

A betting exchange system method for compensating for network latency for a sports betting game, comprising: providing a sports betting game on a network, the sports betting game associated with at least a live sporting event; storing laying wager data in a database associated with the sports betting game; sending a first stream of data to a mobile device, the first stream of data containing laying wager data with the mobile device; and sending a second stream of data to the mobile device, the second stream of data containing media data.

For example, the betting exchange system method sends video feeds to all users who receive lay bets, the betting exchange system compensates for latency of users by providing streams of data, video high bandwidth and second media data (count of frames) low bandwidth, and where the mobile device can count frames, and the market will close when the receiver has received the second media data related to frame count, even if the video feed hasn't caught up.

A machine learning betting system method for compensating for network latency for a sports betting game, comprising: providing a sports betting game on a network, the sports betting game associated with at least a live sporting event; storing wager data in a database associated with the sports betting game; sending a first stream of data to a mobile device, the first stream of data containing wager data with the mobile device; and sending a second stream of data to the mobile device, the second stream of data containing media data.

For example, the machine learning betting system sends video feeds to all users who receive bets, the betting exchange system compensates for latency of users by providing streams of data, video high bandwidth and second media data (count of frames) low bandwidth, and where the mobile device can count frames, and the market will close when the receiver has received the second media data related to frame count, even if the video feed hasn't caught up. A supervised machine learning could change the total count of the count of frames over time to optimize the count for each user based upon their specific latency.

### EMBODIMENT 51A

### Odds Making Through Context Specific Simulations

The embodiments are generally related to play-by-play wagering on live sporting events.

Embodiments can include methods and systems for odds making through context specific simulations. In one embodiment, a method of calculating odds with multiple simulations for a play-by-play wagering network may be provided. The method can include collecting real-time sensor data from a live sporting event upon which play-by-play wagers can be placed; calculating odds for wagers placed on the live sporting even through the play-by-play wagering network based on historical play data; generating a plurality of simulations for outcomes of plays within the live sporting event; and updating the odds for wagers placed on the live sporting event through the play-by-play wagering network based on the plurality of simulations for outcomes of plays within the live sporting event.

In another embodiment, a system for calculating odds with multiple simulations for a play-by-play wagering network can include a play by play wagering network; one or more sensors that collect real-time sensor data from the live sporting event upon which play-by-play wagers can be placed on the play-by-play wagering network; a historical plays database which contains historical plays data for live sporting events; an odds calculation module that calculates odds for the wagers placed on the live sporting event based on the historical plays data; an initial simulation module which generates a plurality of simulations for outcomes of plays within the live sporting event; and a simulation adjustment module which updates the odds for wagers placed on the live sporting event through the play-by-play wagering network based on the plurality of simulations for outcomes of plays within the live sporting event.

A method of calculating odds by running simulations for the game from the current point so that the simulations would reduce the number of possible outcomes because a portion of the game will have already been played.

### EMBODIMENT 51B

A method of calculating odds with multiple simulations for a play-by-play wagering network, comprising: collecting real-time sensor data from a live sporting event upon which play-by-play wagers can be placed; calculating odds for wagers placed on the live sporting even through the play-by-play wagering network based on historical play data; generating a plurality of simulations for outcomes of plays within the live sporting event; and updating the odds for wagers placed on the live sporting event through the play-by-play wagering network based on the plurality of simulations for outcomes of plays within the live sporting event.

A betting exchange system method of calculating odds with multiple simulations for a play-by-play wagering network, comprising: collecting real-time sensor data from a live sporting event upon which play-by-play laying wagers can be placed; calculating odds for laying wagers placed on the live sporting even through the play-by-play wagering network based on historical play data; generating a plurality of simulations for outcomes of plays within the live sporting event; and updating the odds for laying wagers placed on the live sporting event through the play-by-play wagering network based on the plurality of simulations for outcomes of plays within the live sporting event.

For example, in a betting exchange system method, a pitcher has pitched 7 innings, and the betting exchange system creates simulations of next events for lay bets to be placed, since the pitcher has pitched 7 innings, the new simulation for next events includes taking the pitcher out of the game, based upon 3 balls thrown in a row of the previous pitches.

A machine learning betting system method of calculating odds with multiple simulations for a play-by-play wagering network, comprising: collecting real-time sensor data from a live sporting event upon which play-by-play wagers can be placed; calculating by using machine learning, odds for wagers placed on the live sporting even through the play-by-play wagering network based on historical play data; generating a plurality of simulations for outcomes of plays within the live sporting event; and updating the odds for wagers placed on the live sporting event through the play-by-play wagering network based on the plurality of simulations for outcomes of plays within the live sporting event.

For example, in a machine learning betting system method, a pitcher has pitched 7 innings, and the machine learning system creates simulations based upon supervised learning for next events for bets to be placed, since the pitcher has pitched 7 innings, the supervised learning determined a new simulation for next events includes taking the pitcher out of the game, based upon 3 balls thrown in a row of the previous pitches.

### EMBODIMENT 52A

### Preloading Wagers

The embodiments are generally related to play by play wagering on live sporting events

A method of providing odds more quickly by calculating the odds for subsequent plays based on the variety of potential outcomes for the current play. Odds for the third pitch in an at-bat based on if the second pitch ends up being a ball or a strike.

### EMBODIMENT 52B

A system for generating odds in a play-by-play sports betting network comprising: a database storing wagers of a play-by-play wagering game during a live sporting event, and an odds calculation module that performs at least four different calculations for odds on a play of the live sporting event, and a hybrid odds module that receives odds from the odds calculation module and determines hybrid odds using at least two of the four different calculated odds, wherein the hybrid odds are for a play immediately following a next play and the odds are modified based on historical data.

A betting exchange system for generating odds in a play-by-play sports betting network comprising: a database storing wagers of a play-by-play wagering game during a live sporting event, and an odds calculation module that performs at least four different calculations for odds on a play of the live sporting event, and a hybrid odds module that receives odds from the odds calculation module and determines hybrid odds using at least two of the four different calculated odds, wherein the hybrid odds are for a play immediately following a next play and the laying wager odds are modified based on historical data.

For example, the betting exchange system method performs four different laying bet odds on a next play, for example similar bets of similar plays are used as a history and the four calculations are average to history, median to history, 10% over average to history, 10% lower than median to history, these odds are used for a hybrid odds module to create a single conservative laying bet (−10% of the average of all four calculations).

A machine learning betting system for generating odds in a play-by-play sports betting network comprising: a database storing wagers of a play-by-play wagering game during a live sporting event, and an odds calculation module that performs at least four different calculations for odds on a play of the live sporting event, and a hybrid odds module that receives odds from the odds calculation module and determines hybrid odds using at least two of the four different calculated odds, wherein the machine learning based hybrid odds are for a play immediately following a next play and the odds are modified based on historical data.

For example, the in a machine learning betting system method performs four different laying bet odds on a next play, for example similar bets of similar plays are used as a history and the four calculations are average to history, median to history, 10% over average to history, 10% lower than median to history, these odds are used for a supervised machine learning hybrid odds module to create a single conservative laying bet evaluating successful hybrid bets for the type each type of bettor).

### EMBODIMENT 53A

Method of Displaying a Notification from a Betting Application Using AI that can Impact Normal Betting

The present disclosure is generally related to play by play wagering on live sporting events.

A system for wagering on outcomes of a live sporting event. The system includes an artificial intelligence-based process which will notify users when wagers that would be of interest to them are available. These notifications could be used to drive users to wagers where there is an imbalance wagers in order to reduce risk for the offeror of the wager.

### EMBODIMENT 53B

A method of providing wagers in a play by play wagering system, comprising: receiving data from a live sporting event upon which wagers can be placed on single plays inside of that live event, collecting preferred wager data from at least one wagering game account, detecting a loss risk based on a calculated imbalance of wagers placed on one possible outcome of an upcoming play, and sending one or more notifications based on preferred wagering data as a result of detecting an imbalance of wagers that at least meets a predetermined threshold.

A betting exchange system method of providing laying wagers in a play by play wagering system, comprising: receiving data from a live sporting event upon which laying wagers can be placed on single plays inside of that live event, collecting preferred laying wager data from at least one laying wagering game account, detecting a loss risk based on a calculated imbalance of laying wagers placed on one possible outcome of an upcoming play, and sending one or more notifications based on preferred laying wagering data as a result of detecting an imbalance of wagers that at least meets a predetermined threshold.

For example, a betting exchange system method finds a there is a need for more lay bets that the betting exchange system determines that a new lay bettor (in the betting exchanges database) would like and send a text message to the new lay bettor come to the betting exchange to place the lay bet.

A machine learning betting system method of providing wagers in a play by play wagering system, comprising: receiving data from a live sporting event upon which wagers can be placed on single plays inside of that live event, collecting preferred wager data from at least one wagering game account, using machine learning to detect a loss risk based on a calculated imbalance of wagers placed on one possible outcome of an upcoming play, and sending one or more notifications based on preferred wagering data as a result of detecting an imbalance of wagers that at least meets a predetermined threshold.

For example, a machine learning betting system method finds a there is a need for more bets that the machine learning betting system determines through a supervised machine learning module that a new lay bettor is needed and used the betting exchanges database to find new bettors that may like to bet and the machine learning betting system send a text message to the new lay bettor come to the betting exchange to place the lay bet. The supervised machine learning determines how many and what type of new bettors are needed and how many texts are needed to get the right amount of new bettors to bet.

### EMBODIMENT 54A

### Method of Displaying a Rolling Ticker on a Sports Betting User Interface

The disclosures are generally related to in-play or in-play wagering on live sporting events.

A user's wager history and previous interactions with a ticker element on a wagering app can be used to identify the user's wager preferences and tendencies. These preferences can then be used to personalize the order in which ticker elements may be displayed to a user while viewing available wagers. The available wagers can additionally be used with the user preferences to improve the relevance of the ticker elements displayed to both the user and the wagers available to the user to place.

### EMBODIMENT 54B

A method for customizing and displaying a rolling ticker feed on a sport wagering network, comprising: retrieving at least one wager preference from a user database; retrieving at least one available wager from an odds database; displaying at least one available wager on a wagering application; retrieving at least one active ticker element from a ticker database; determining at least one wager score for an active ticker element; determining at least one relevance score for an active ticker element; determining at least one ticker priority score using at least one wager score and one relevance score; utilizing at least one ticker priority score to display at least one ticker element on the wagering application; determining input selection of at least one ticker element on the wagering application; receiving at least one input selection from the wagering application; offering at least one available wager on the wagering application; and adjusting at least one account balance to reflect an outcome of an event.

A betting exchange system method for customizing and displaying a rolling ticker feed on a sport wagering network, comprising: retrieving at least one laying wager preference from a user database; retrieving at least one available laying wager from an odds database; displaying at least one available laying wager on a wagering application; retrieving at least one active ticker element from a ticker database; determining at least one laying wager score for an active ticker element; determining at least one relevance score for an active ticker element; determining at least one ticker priority score using at least one laying wager score and one relevance score; utilizing at least one ticker priority score to display at least one ticker element on the wagering application; determining input selection of at least one ticker element on the wagering application; receiving at least one input selection from the wagering application; offering at least one available laying wager on the wagering application; and adjusting at least one account balance to reflect an outcome of an event.

For example, in a betting exchange system method, if a user has a favorite team like the red sox and a favorite player on the team, the betting exchange system can determine the user who has bet on their favorite teams and display, in ticker format the current laying bets to choose from in the priority of the ticker based upon the user preferences to accept laying bets.

A machine learning betting system method for customizing and displaying a rolling ticker feed on a sport wagering network, comprising: retrieving at least one wager preference from a user database; retrieving at least one available wager from an odds database; displaying at least one available wager on a wagering application; retrieving at least one active ticker element from a ticker database; determining by using machine learning, at least one wager score for an active ticker element; determining at least one relevance score for an active ticker element; determining at least one ticker priority score using at least one wager score and one relevance score; utilizing at least one ticker priority score to display at least one ticker element on the wagering application; determining input selection of at least one ticker element on the wagering application; receiving at least one input selection from the wagering application; offering at least one available wager on the wagering application; and adjusting at least one account balance to reflect an outcome of an event.

For example, in a machine learning betting system method, if a user has a favorite team like the red sox and a favorite player on the team, the betting exchange system can determine using unsupervised machine learning users who has bet on their favorite teams and display, in ticker format the current bets to choose from, in the priority of the ticker based upon the user preferences to accept the bets.

### EMBODIMENT 55A

### Method of Parlaying Events in Different Games

The embodiments are generally related to play-by-play wagering on live sporting events.

A method of enticing a user-bettor to place a bet on the last play of one game and the first play of the next scheduled game through the offer of improved odds, for example, to entice bettors to keep betting game after game. This offer would allow a user to parlay the last event within one game with the first event in another game to entice the user to continue using the wagering platform.

### EMBODIMENT 55B

A method of offering a personalized parlay in a play-by-play sports betting network, comprising: storing wagers of a play-by-play wagering game during live sporting events, and calculating a first set of odds on at least one outcome of the last play in a live sporting event, and calculating a second set of odds on at least one outcome, the first play in a second live event, and displaying a parlay wager offer on the combined outcome of a play of the first live event and a play of the second live event, and wherein the second live event begins after the first live event.

A betting exchange system method of offering a personalized parlay in a play-by-play sports betting network, comprising: storing laying wagers of a play-by-play wagering game during live sporting events, and calculating a first set of odds on at least one outcome of the last play in a live sporting event, and calculating a second set of odds on at least one outcome, the first play in a second live event, and displaying a parlay laying wager offer on the combined outcome of a play of the first live event and a play of the second live event, and wherein the second live event begins after the first live event.

For example, the betting exchange system method calculates a laying bet for a “pass” in the next play for football, and determines the parlay of an “interception” on the “pass” and a second laying odds is determined, based upon both plays happening.

A machine learning betting system method of offering a personalized parlay in a play-by-play sports betting network, comprising: storing wagers of a play-by-play wagering game during live sporting events, and calculating using a machine learning module a first set of odds on at least one outcome of the last play in a live sporting event, and calculating the machine learning module a second set of odds on at least one outcome, the first play in a second live event, and displaying a parlay wager offer on the combined outcome of a play of the first live event and a play of the second live event, and wherein the second live event begins after the first live event.

For example, the machine learning system method calculates using a supervised machine learning module a bet for a “pass” in the next play for football, and the supervised machine learning system calculates using a machine learning module also determines the parlay of an “interception” on the “pass” and a second odds is determined, based upon both plays happening. The supervised machine learning module uses, for each play finds second possibly plays and their odds and the historical results and choses the best possible first and second play based upon average profit to the house based upon range and volume of current and historical bettors.

### EMBODIMENT 56A

### Method of Determining a User'S Long-Term Value and Finding Similar New User

The present disclosure is generally related to play-by-play wagering on live sporting events.

The present disclosure provides a method of determining a user's long-term value to a wagering network and identifying new users similar to the users that provide long-term value to the wagering network. This method determines a user's long-term value and the user's engagement with a wagering network and places the users into cohorts. The method also provides finding correlations with the users' data and then correlating the data of new users and comparing the correlation coefficients of the new users with the older users to group the new users into the cohorts similar to the older users to predict their long-term value to the wagering network.

### EMBODIMENT 56B

A method of determining a user's long-term value and finding a similar new user on a wagering network, comprising; determining a user's long-term value, and determining a user's engagement, and placing the users into various cohorts based on long term value and engagement, and performing correlations on the user's data, and performing correlations on the new user's data, and comparing the user's correlations with the new user's correlations, and determining a match of correlations between the new user and the user to predict the new user's long-term value and engagement on a wagering network.

A betting exchange system method of determining a user's long-term value and finding a similar new user on a wagering network, comprising; determining a user's long-term value as a laying bettor, and determining a user's engagement, and placing the users into various cohorts based on long term value of their laying bets and engagement, and performing correlations on the user's data, and performing correlations on the new user's data, and comparing the user's correlations with the new user's correlations, and determining a match of correlations between the new user and the user to predict the new user's long-term value and engagement on a wagering network.

For example, in a betting exchange system method, as users are evaluated for their long-term profit value of lay betting on the betting exchange, as new plays occurs, predictions are made based upon the users past lay betting long term value and the new users that may brought into the betting exchange, and although the user may not be profitable long term, the new users that the new users have brought in are profitable, so the user is continued to be given odds, even though it is likely to be not profitable for that user, its profitable for the groups they bring into the betting exchange.

A machine learning betting system method used machine learning in determining a user's long-term value and finding a similar new user on a wagering network, comprising; determining a user's long-term value, and determining a user's engagement, and placing the users into various cohorts based on long term value and engagement, and performing correlations on the user's data, and performing correlations on the new user's data, and comparing the user's correlations with the new user's correlations, and determining a match of correlations between the new user and the user to predict the new user's long-term value and engagement on a wagering network.

For example, in a machine learning betting system method, as users are evaluated using unsupervised machine learning for their long-term profit value of lay betting on the betting exchange, as new plays occurs, predictions are made based upon the users past betting long term value and the new users that may brought into the betting exchange, and although the user may not be profitable long term, the new users that the new users have brought in are profitable, so the user is continued to be given odds, even though it is likely to be not profitable for that user, its profitable for the groups they bring into the machine learning system. The unsupervised machine learning for calculating users long-term profit value may include overall frequency of betting, when the bet of plays to help the overall machine learning system be profitable, as well as sizes of their bets. The unsupervised machine learning for their long-term profit value learns as games are played when users long term value increases or decreases.

### EMBODIMENT 57A

### Odds Movement Indicator

The present disclosures are generally related to play-by-play wagering on live sporting events.

A method of displaying odds for micro-markets that indicate to the user the direction and amplitude of odds movement with red for down and green for up, with the shade indicative of amplitude, darker the arrow, the bigger the move.

### EMBODIMENT 57B

A method of displaying changes in odds for a sports wagering system, comprising: collecting a set of wager odds data stored in an odds database and determining if there is second set of odds data for the same wager in the odds database; calculating a percentage of change from the collected set of wager odds and the second set of wager odds data; displaying the percentage of change to the user through at least one visual icon on a device; and adjusting the direction, size, color, and opacity of the visual icon depending on the magnitude of change in the odds data.

A betting exchange system method of displaying changes in odds for a sports wagering system, comprising: collecting a set of laying wager odds data stored in an odds database and determining if there is second set of laying wager odds data for the same laying wager in the odds database; calculating a percentage of change from the collected set of laying wager odds and the second set of laying wager odds data; displaying the percentage of change to the user through at least one visual icon on a device; and adjusting the direction, size, color, and opacity of the visual icon depending on the magnitude of change in the odds data.

For example, in a betting exchange system method if a first odds were 2:1 on the previous play on a “pass” in football, and the new calculated odds are 2.2:1 for a “run”, the display icon may be light green, meaning the odds are positive from the last (green) and only 10%, lighter green.

A machine learning betting system method of displaying changes in odds for a sports wagering system, comprising: collecting a set of wager odds data stored in an odds database and determining by using machine learning if there is second set of odds data for the same wager in the odds database; calculating a percentage of change from the collected set of wager odds and the second set of wager odds data; displaying the percentage of change to the user through at least one visual icon on a device; and adjusting the direction, size, color, and opacity of the visual icon depending on the magnitude of change in the odds data.

For example, in a machine learning betting system method, if a first odds were 2:1 on the previous play on a “pass” in football, and the new calculated odds using supervised machine learning are 2.2:1 for a “run”, the display icon may be light green, meaning the odds are positive from the last (green) and only 10%, lighter green.

### EMBODIMENT 58A

### Method for Indirect Odds Making

The present disclosures are generally related to in-play wagering on live sporting events.

The present disclosure provides a method for indirect odds making by using predictions from similar wagers placed by users by calculating the wager odds for an upcoming play by play wager, determining the active users on a wagering network, determining the user's historical tendencies from similar types of wagers, performing correlations between the active user's historical wager data and the wager odds, determining the selected wager and the amount to be wagered for each user, determining the total amount wagered for each side of the wager, determining if there is even action for the wager and if there is not even action updating or altering the wager odds to ensure even action from the users when the wager odds are made available on the wagering network.

### EMBODIMENT 58B

A method for indirect odds making on a sport wagering network, comprising: determining at least an active user and a set of wagering odds on a wagering network; determining at least a historical user data set for at least one type of wager; supplementing at least additional user data if the historical user data set does not meet a predetermined user data threshold amount; determining if at least a correlation exists between the historical user data set and the set of wagering odds and if the correlation is above a predetermined correlation threshold amount; determining a probability that a user will wager for possible wager outcomes and an average amount wagered by the user; determining if the probability exceeds a predetermined probability threshold amount; determining how many users will wager on an outcome and at least an amount to be wagered on the outcome; determining if an even action exists for both sides of a wager and determining an adjustment percentage if the even action does not exist; and offering at least wager odds on a wagering application.

A betting exchange system method for indirect odds making on a sport wagering network, comprising: determining at least an active user and a set of laying wagering odds on a wagering network; determining at least a historical user data set for at least one type of laying wager; supplementing at least additional user data if the historical user data set does not meet a predetermined user data threshold amount; determining if at least a correlation exists between the historical user data set and the set of laying wagering odds and if the correlation is above a predetermined correlation threshold amount; determining a probability that a user will wager for possible laying wager outcomes and an average amount laying wagered by the user; determining if the probability exceeds a predetermined probability threshold amount; determining how many users will wager laying bets on an outcome and at least an amount to be wagered on the outcome; determining if an even action exists for both sides of a laying wager and determining an adjustment percentage if the even action does not exist; and offering at least laying wager odds on a wagering application.

For example, in a betting exchange system method, when laying bets are placed, as users accept the laying bets, the betting exchange system determine the other side of the bets and whether there is even action (bets covered with a profit to the exchange), and if not, odds are changed for new laying odds to get to even action. The historical data is used each time to determine correlations to past data as well as meeting correlation thresholds. Also, the probability calculation is used to determine if new laying odds will be covered with a match, and this probability will change the odds.

A machine learning betting system method for indirect odds making on a sport wagering network, comprising: determining at least an active user and a set of wagering odds on a wagering network; determining at least a historical user data set for at least one type of wager; supplementing at least additional user data if the historical user data set does not meet a predetermined user data threshold amount; determining if at least a correlation exists between the historical user data set and the set of wagering odds and if the correlation is above a predetermined correlation threshold amount; determining a probability using machine learning that a user will wager for possible wager outcomes and an average amount wagered by the user; determining if the probability exceeds a predetermined probability threshold amount; determining how many users will wager on an outcome and at least an amount to be wagered on the outcome; determining if an even action exists for both sides of a wager and determining an adjustment percentage if the even action does not exist; and offering at least wager odds on a wagering application.

For example, in a machine learning betting system method, when laying bets are placed, as users accept the laying bets, the betting exchange system determine the other side of the bets and whether there is even action (bets covered with a profit to the exchange), and if not, odds are changed for new laying odds to get to even action. The historical data is used each time to determine correlations to past data as well as meeting correlation thresholds. Also, a supervised machine learning probability calculation is used to determine if new laying odds will be covered with a match, and this probability will change the odds. The supervised machine learning probability calculation uses trends in past data to see if the trends of the new probability calculation are in line with past and current bets.

### EMBODIMENT 59A

### Rolling Pitch Count Wagers

The present disclosures are generally related to in-play wagering on live sporting events.

The present disclosure provides a method to create new wagers and optimize odds in an online play by play sports betting game by creating odds for a first specific play by play event creating wagering odds for a sequence of potential possibilities of the outcome of the play, allowing the user to wager on one or more of the wagering odds within the sequence, then after the play ends create new wagering odds for the continuation of the sequence of possibilities for the outcome of the play and allowing the user to wager on the new or old wagering odds.

### EMBODIMENT 59B

A method for indirect odds making on a sport wagering network, comprising: determining at least an active user and a set of wagering odds on a wagering network; determining at least a historical user data set for at least one type of wager; supplementing at least additional user data if the historical user data set does not meet a predetermined user data threshold amount; determining if at least a correlation exists between the historical user data set and the set of wagering odds and if the correlation is above a predetermined correlation threshold amount; determining a probability that a user will wager for possible wager outcomes and an average amount wagered by the user; determining if the probability exceeds a predetermined probability threshold amount; determining how many users will wager on an outcome and at least an amount to be wagered on the outcome; determining if an even action exists for both sides of a wager and determining an adjustment percentage if the even action does not exist; and offering at least wager odds on a wagering application.

A betting exchange system method for indirect odds making on a sport wagering network, comprising: determining at least an active user and a set of wagering odds on a wagering network; determining at least a historical user data set for at least one type of laying wager; supplementing at least additional user data if the historical user data set does not meet a predetermined user data threshold amount; determining if at least a correlation exists between the historical user data set and the set of wagering odds and if the correlation is above a predetermined correlation threshold amount; determining a probability that a user will wager for possible wager outcomes and an average amount wagered by the user; determining if the probability exceeds a predetermined probability threshold amount; determining how many users will wager on an outcome and at least an amount to be wagered on the outcome; determining if an even action exists for both sides of a wager and determining an adjustment percentage if the even action does not exist; and offering at least wager odds on a wagering application.

For example, in a betting exchange system method, when laying bets are placed, as users accept the laying bets, the betting exchange system determines the other side of the bets and whether there is even action (bets covered with a profit to the exchange), and if not, odds are changed for new laying odds to get to even action. The historical data is used each time to determine correlations to past data as well as meeting correlation thresholds. Also, the probability calculation is used to determine, with any new data in the play before the market is suspended (such as players have shifted in the field after the first laying net is made) if new laying odds will be covered with a match, and this probability will change the odds.

A machine learning betting system method for indirect odds making on a sport wagering network, comprising: determining at least an active user and a set of wagering odds on a wagering network; determining at least a historical user data set for at least one type of wager; supplementing at least additional user data if the historical user data set does not meet a predetermined user data threshold amount; determining if at least a correlation exists between the historical user data set and the set of wagering odds and if the correlation is above a predetermined correlation threshold amount; determining by a machine learning probability module that a user will wager for possible wager outcomes and an average amount wagered by the user; determining if the machine learning probability module exceeds a predetermined probability threshold amount; determining how many users will wager on an outcome and at least an amount to be wagered on the outcome; determining if an even action exists for both sides of a wager and determining an adjustment percentage if the even action does not exist; and offering at least wager odds on a wagering application.

For example, in a machine learning betting system method, when bets are placed, as users accept the bets, the machine learning system determines the other side of the bets and whether there is even action (bets covered with a profit to the machine learning system), and if not, odds are changed for new odds to get to even action. The historical data is used each time to determine correlations to past data as well as meeting correlation thresholds. Also, a machine learning probability module is used to determine, with any new data in the play before the market is suspended (such as players have shifted in the field after the first laying net is made) if new odds will be covered with a match, and this probability will change the odds.

### EMBODIMENT 60A

### Method of Displaying Sports Player Information on a Sports Betting User Interface

The present disclosures are generally related to play-by-play wagering on live sporting events.

A method of displaying news relevant to the user of a play-by-play wagering system. For example, sending a notification to a user that a player they frequently wager on will be up in the next inning, and there are available wagers on the outcome.

### EMBODIMENT 60B

A method for displaying relevant news to a user of a sports wagering network, comprising: collecting news data from a news database and determining relevant news data to a user by utilizing metadata, at least one algorithm, a news title, a date, and/or a player name; sending relevant news data to a mobile device communicatively coupled to the sports wagering network and displaying the relevant news data on a wagering application on the mobile device; and determining at least one available wager including at least one player stored in a player follower database and displaying that wager on the mobile device.

A betting exchange system method for displaying relevant news to a user of a sports wagering network, comprising: collecting news data from a news database and determining relevant news data to a user by utilizing metadata, at least one algorithm, a news title, a date, and/or a player name; sending relevant news data to a mobile device communicatively coupled to the sports wagering network and displaying the relevant news data on a wagering application on the mobile device; and determining at least one available laying wager including at least one player stored in a player follower database and displaying that wager on the mobile device.

For example, in a betting exchange system method, the news of a pitcher playing a fifteen-inning game a few days earlier is found when the same pitcher starts a new game. The betting exchange system would provide this news article synopsis on a proposed lay bet for the pitcher. This news article may affect the lay wagerers desire to accept the bet or not.

A machine learning betting system method for displaying relevant news to a user of a sports wagering network, comprising: collecting news data from a news database and determining relevant news data to a user by utilizing metadata, at least one machine learning algorithm, a news title, a date, and/or a player name; sending relevant news data to a mobile device communicatively coupled to the sports wagering network and displaying the relevant news data on a wagering application on the mobile device; and determining at least one available wager including at least one player stored in a player follower database and displaying that wager on the mobile device.

For example, in a machine learning betting system method, the news of a pitcher playing a fifteen-inning game a few days earlier is found by a supervised machine learning system, when the same pitcher starts a new game. The supervised machine learning system would provide this news article synopsis on a proposed lay bet for the pitcher. This news article may affect the wagerers desire to accept the bet or not.

### EMBODIMENT 61A

### In-Play Wagering for Pooled Prizes by Wins

The present embodiments are generally related to play by play wagering on live sporting events.

The present disclosure provides a method of in-play wagering for pooled or contest prizes by wins in which users are placed in various cohorts based on skill and then allowed to compete against one another in a contest for a prize that is won by the user with the highest total amount of wins during the contest. This method provides grouping the users of a wagering network into cohorts and allowing them to join a contest based on the cohort and compete for a prize which is won by the user with the most wins during the length of the contest.

### EMBODIMENT 61B

A method for offering pooled prizes by wins in a play-by-play wagering network, comprising; grouping users into cohorts, and creating a contest for users, and allowing a user to join a contest based on their cohort, and determining the number of wins a user achieves during the contest, and awarding a prize to the user with the most wins during the contest.

A betting exchange system method for offering pooled prizes by wins in a play-by-play wagering network that uses lay betting, comprising; grouping users into cohorts, and creating a contest for users, and allowing a user to join a contest based on their cohort, and determining the number of wins a user achieves during the contest, and awarding a prize to the user with the most wins during the contest.

For example, in a betting exchange system method, grouping users into 10 groups, where the first or top group has one the top 10% of the winning lay bets the most time for the highest profit, and other groups are divided in 9 other segments, each segment making the next 10% laying wins bets for time and profit all the way down to segments that lost lay bests for time and losses. Contest are created for each of the groups, based upon their status, for instance, the top 10% group may be allowed to use some of their winning to bet on a new bet parlay at enhanced odds to keep their winnings in the betting exchange whereas the lowest segment group may have their names entered into a jackpot to entice this lowest band to keep on betting.

A machine learning betting system method for offering pooled prizes by wins in a play-by-play wagering network, comprising; grouping users into cohorts, using machine learning to create a contest for users, and allowing a user to join a contest based on their cohort, and determining the number of wins a user achieves during the contest, and awarding a prize to the user with the most wins during the contest.

For example, in a machine learning betting system method, grouping users into 10 groups, where the first or top group has one the top 10% of the winning lay bets the most time for the highest profit, and other groups are divided in 9 other segments, each segment making the next 10% laying wins bets for time and profit all the way down to segments that lost lay bests for time and losses. Contest are created using supervised machine learning for each of the groups, based upon their status and their history of accepting new bets. The top 10% group may be allowed to use some of their winning to bet on a new bet parlay at enhanced odds to keep their winnings in the betting exchange whereas the lowest segment group may have their names entered into a jackpot to entice this lowest band to keep on betting.

### EMBODIMENT 62A

### In-Play Wagering for Pooled Prizes by Points

The present embodiments are generally related to play by play wagering on live sporting events.

The present disclosure provides a method of in-play wagering for pooled or contest prizes by points in which users are placed in various cohorts based on skill and then allowed to compete against one another in a contest for a prize that is won by the user with the total amount of points earned during a contest. This method provides grouping the users of a wagering network into cohorts and allowing the users to join a contest based on the cohort to compete for a prize that the user with the most points wins during the length of the contest.

### EMBODIMENT 62B

A method for offering pooled prizes by points on a play-by-play wagering network, comprising; grouping users into cohorts, and creating a contest for users, and allowing a user to join a contest based on their cohort, and determining the number of points a user earns during the contest, and awarding a prize to the user with the most points during the contest.

A betting exchange system method for offering pooled prizes by points on a play-by-play wagering network that allows lay betting, comprising; grouping users into cohorts, and creating a contest for users, and allowing a user to join a contest based on their cohort, and determining the number of points a user earns during the contest, and awarding a prize to the user with the most points during the contest.

For example, the betting exchange system method defines a group of consistent winners (have won 5 lay bets in a row) and provides a contest of a set of sports questions of the players of the game, over the course of the game and allowing points for each right answer, then awarding a prize to the player who had the most points.

A machine learning betting system method for offering pooled prizes by points on a play-by-play wagering network, comprising; grouping users into cohorts, and creating, using machine learning, a contest for users, and allowing a user to join a contest based on their cohort, and determining the number of points a user earns during the contest, and awarding a prize to the user with the most points during the contest.

For example, the machine learning betting system method defines a group of consistent winners (have won 5 lay bets in a row) and provides, using unsupervised machine learning a contest of a set of sports questions of the players of the game, over the course of the game and allowing points for each right answer, then awarding a prize to the player who had the most points. The unsupervised machine learning creates learnings between type of winners/losers (consecutive winners, long term winners, a new large winner, long term losers etc, where by the contest have been varied in the machine learning system, that overtimes finds the best contests for the type of winners/losers.

### EMBODIMENT 63A

### Method of Providing Wagering Notifications Through Haptics

The present disclosures are generally related to play-by-play or in-play wagering on live sporting events.

The wager preferences of the user of a wagering app can be identified and paired with a recognizable notification including haptics so that when a wagering opportunity matching the user's preferences is available, the user is notified using a recognizable notification to increase the likelihood that the user will act upon the notification and place a wager.

### EMBODIMENT 63B

A method for providing a haptic notification to a user or cohort of users on a sport wagering network, comprising: determining at least one haptic notification preference; delivering at least one haptic notification to a user based on a haptic notification preference; determining at least one user status based on an interaction with a haptic notification; displaying at least one wager based on a user status on a wagering application; and determining if at least one wager was placed and adjusting at least one user balance depending on an outcome of a wager.

A betting exchange system method for providing a haptic notification to a user or cohort of users on a sport wagering network, comprising: determining at least one haptic notification preference; delivering at least one haptic notification to a user based on a haptic notification preference; determining at least one user status based on an interaction with a haptic notification; displaying at least one laying wager based on a user status on a wagering application; and determining if at least one laying wager was placed and adjusting at least one user balance depending on an outcome of a wager.

For example, the betting exchange system method uses its databases to determine users that should be notified of a laying bet, the betting exchange systems send a haptic notification to the users based upon their preference (e.g. one user prefers a long vibration for any new lay bet, another user prefers a series of three short vibrations for lay bets over 10:1), the betting exchange checks on the responses or the users and sends the laying bet to those who have logged into the betting exchange to bet.

A machine learning betting system method for providing a haptic notification to a user or cohort of users on a sport wagering network, comprising: determining using machine learning at least one haptic notification preference; delivering at least one haptic notification to a user based on a haptic notification preference; determining at least one user status based on an interaction with a haptic notification; displaying at least one wager based on a user status on a wagering application; and determining if at least one wager was placed and adjusting at least one user balance depending on an outcome of a wager.

For example, the in a machine learning betting system method, uses its databases to determine users that should be notified of a laying bet, the machine learning systems sends a haptic notification to the users based upon unsupervised learning to find their preference (e.g. over time for each user various haptics responses are sent and it is found that one user prefers a long vibration for any new lay bet, another user prefers a series of three short vibrations for lay bets over 10:1), the machine learning checks on the responses or the users and sends the laying bet to those who have logged into the betting exchange to bet.

### EMBODIMENT 64A

### Method of Storing Wagering Data Locally

The present disclosures are generally related to in-play wagering on live sporting events.

The present disclosure provides a method for storing wagering data locally on a user's device by allowing the user to request to download their data, the wagering network extracting the user's data from their database, sending the data to the user, and allowing the user to store the data locally on their device. Also, the method allows to view the data and analyze the data to allow the user to set limits that are locally stored on the user's device to prevent the user from wagering too much money on types of wagers that they historically perform poorly on. Lastly, this method provides the ability to allow 3rd parties to connect to the locally stored data through an API connection, thus allowing the user to use different systems or applications to analyze their data further.

### EMBODIMENT 64B

A method for locally storing wagering data from a wagering network, comprising: receiving at least input data from a mobile device; requesting at least user data from a send data module and receiving at least user data from the send data module; receiving a request for at least user data from a data collection module, extracting at least user data from a user database, and sending at least user data to the data collection module; storing at least user data in a local user database; receiving at least wager selection data from a user; filtering the local user database for at least one of available wager data or user data and analyzing available wager data or user data; displaying at least a data analytic on a data viewer; and determining at least wager limit data and storing at least wager limit data in the local user database.

A betting exchange system method for locally storing wagering data from a wagering network, comprising: receiving at least input data from a mobile device; requesting at least user data from a send data module and receiving at least user data from the send data module; receiving a request for at least user data from a data collection module, extracting at least user data from a user database, and sending at least user data to the data collection module; storing at least user data in a local user database; receiving at least a lay wager selection data from a user; filtering the local user database for at least one of available lay wager data or user data and analyzing available laying wager data or user data; displaying at least a data analytic on a data viewer; and determining at least wager limit data and storing at least laying wager limit data in the local user database.

For example, the present disclosure provides a betting exchange system method for storing laying wagering data locally on a user's device by allowing the user to request to download their data, the wagering network extracting the user's data from their database, sending the data to the user, and allowing the user to store the data locally on their device. Also, the method allows to view the data and analyze the data to allow the user to set limits that are locally stored on the user's device to prevent the user from wagering too much money on types of wagers that they historically perform poorly on.

A machine learning betting system method for locally storing wagering data from a wagering network, comprising: receiving at least input data from a mobile device; requesting at least user data from a send data module and receiving at least user data from the send data module; receiving a request for at least user data from a data collection module, extracting at least user data from a user database, and sending at least user data to the data collection module; storing at least user data in a local user database; receiving at least wager selection data from a user; using machine learning to filter the local user database for at least one of available wager data or user data and analyzing available wager data or user data; displaying at least a data analytic on a data viewer; and determining at least wager limit data and storing at least wager limit data in the local user database.

For example, the present disclosure provides a in a machine learning betting system method, method for storing laying wagering data locally on a user's device by allowing the user to request to download their data, the wagering network extracting the user's data from their database, sending the data to the user, and allowing the user to store the data locally on their device. Also, the method allows, using unsupervised machine learning, to view the data and analyze the data to allow the user to set limits that are locally stored on the user's device to prevent the user from wagering too much money on types of wagers that they historically perform poorly on. As various visualization are used, the unsupervised learning learns the best way (via frequency of use) to display data.

### EMBODIMENT 65A

### Method of Providing User Comparison Data

The embodiments are generally related to play-by-play wagering on live sporting events.

An invention consisting of a proprietary method of informing a user of a sports betting application of his or her performance compared to the user's friends or other users (e.g., this user just fell behind his friend, or this user is doing the best out of his group of friends).

### EMBODIMENT 65B

A method for enhancing the user experience of a play-by-play sports betting comprising: providing a database for storing wagers of a play-by-play wagering game during a live sporting event, and allowing the user to store their contacts in the database, and comparing the wagers of the contacts in the database to the wagers of the user at a first time and a second time, and notifying the user of the comparison if the first time is different from the comparison at the second time, and allowing the user options for a chance of diminishing the difference of the wagers comparison.

A betting exchange system method for enhancing the user experience of a play-by-play sports betting comprising: providing a database for storing wagers of a play-by-play wagering game during a live sporting event, and allowing the user to store their contacts in the database, and comparing the laying wagers of the contacts in the database to the wagers of the user at a first time and a second time, and notifying the user of the comparison if the first time is different from the comparison at the second time, and allowing the user options for a chance of diminishing the difference of the laying wagers comparison.

For example, a betting exchange system method allows the user contacts to be loaded in the betting exchange system, and the user makes laying bets and the betting exchange also determines the laying bets of the contacts, This provides a base line of contacts bets, such as how the user is doing from a profit perspective for each contact. The betting system provides the user, on subsequent bets, if the profit of each contact changes from the user and the betting exchange system allows the user more laying bets to diminish the difference to the contacts results. For example, if several contacts are achieving more profit that the user, the betting exchange provides more opportunities for the laying bettor to win more profit.

A machine learning betting system method for enhancing the user experience of a play-by-play sports betting comprising: providing a database for storing wagers of a play-by-play wagering game during a live sporting event, and allowing the user to store their contacts in the database, and comparing using machine learning the wagers of the contacts in the database to the wagers of the user at a first time and a second time, and notifying the user of the comparison if the first time is different from the comparison at the second time, and allowing the user options for a chance of diminishing the difference of the wagers comparison.

For example, in a machine learning betting system method allows the user contacts to be loaded in the betting exchange system, and the user makes laying bets and the betting exchange also determines the laying bets of the contacts, This provides a base line of contacts bets, such as how the user is doing from a profit perspective for each contact. The betting system provides the user, on subsequent bets, if the profit of each contact changes from the user an the betting exchange system, using unsupervised machine learning allows the user more laying bets to diminish the difference to the contacts results. For example, the unsupervised learning “learns” that if several contacts are achieving more profit that the user, the machine learning provides more opportunities for the user to win more profit.

### EMBODIMENT 66A

### On Deck Wagering

The embodiments are generally related to play-by-play wagering on live sporting events.

A method of wagering on micro markets that are not related to the current play. For example, wagering on the outcome of the third batter due up in the inning.

### EMBODIMENT 66B

A method for enhancing the user experience of a play-by-play sports betting comprising: providing database storing wagers of a play-by-play wagering game during a live sporting event, allowing wagers to place a wager on the outcome of a future play, and calculating the odds of the future play based on the current state of the live sporting event, and calculating the odds of future plays are based on the rules of the live sporting event, and allowing the user to see, on a display the calculated odds and to place a bet on these displayed odds

A betting exchange system method for enhancing the user experience of a play-by-play sports betting comprising: providing database storing wagers of a play-by-play wagering game during a live sporting event, allowing wagers to place a laying wager on the outcome of a future play, and calculating the odds of the future play based on the current state of the live sporting event, and calculating the odds of future plays are based on the rules of the live sporting event, and allowing the user to see, on a display the calculated odds and to place a bet on these displayed odds.

For example, in a betting exchange system method, a method of wagering on micro markets that are not related to the current play, such as wagering on the outcome of the third batter due up in the inning. A laying wager in a betting system can bet on any rules-based play event.

A machine learning betting system method for enhancing the user experience of a play-by-play sports betting comprising: providing database storing wagers of a play-by-play wagering game during a live sporting event, allowing wagers to place a wager on the outcome of a future play, and using machine learning, calculating the odds of the future play based on the current state of the live sporting event, and calculating the odds of future plays are based on the rules of the live sporting event, and allowing the user to see, on a display the calculated odds and to place a bet on these displayed odds.

For example, in a machine learning betting system method, a method of wagering on micro markets that are not related to the current play, such as calculating, using unsupervised machine learning odds for wagering on the outcome of the third batter due up in the inning. A wager in a betting system can bet on any rules-based play event. The unsupervised machine learning learns the best rule-based play events to choose from, from data over time, where various rules are randomly chosen based upon current plays are offered to find the bets rules to offer over time.

### EMBODIMENT 67A

### Method of Notifying User of a Known Contact'S Wager

The present disclosures are generally related to play-by-play wagering on live sporting events.

The present disclosure provides a method of notifying a user of a friend's wager allowing the user to place the same wager or the opposite wager to bet with or against their friends. The method includes being able to add friends on a wagering app, determining the current wager market that the user is in, and using the friend data stored to determine if one or more of the user's friends are in the same wager market or participating in wagering on the same live event and then notifying the user if one or more of their friends places a wager through a notification on the wagering app.

### EMBODIMENT 67B

A method for informing a user of wagers of a known contact on a wagering network, comprising: receiving a first set of known contact data from a user and comparing the data to at least an additional set of contact data stored in a user database for a match; storing the match within a contact database; extracting a set of user wager market data from the contact database and querying the user database for at least an additional set of user wager market data for a match; informing the user of the match or an absence of a match; displaying a match on a device of the user; and determining if the user is still in the same wager market.

A betting exchange system method for informing a user of laying wagers of a known contact on a wagering network, comprising: receiving a first set of known contact data from a user and comparing the data to at least an additional set of contact data stored in a user database for a match; storing the match within a contact database; extracting a set of user laying wager market data from the contact database and querying the user database for at least an additional set of user laying wager market data for a match; informing the user of the match or an absence of a match; displaying a match on a device of the user; and determining if the user is still in the same laying wager market.

For example, the betting exchange system method will determine, based upon users contacts, if a user contact is laying bets in the same market as the user, and informs the user of the contact in the market and the laying bet data of that user.

A machine learning betting system method for informing a user of wagers of a known contact on a wagering network, comprising: receiving a first set of known contact data from a user and comparing, using machine learning matching of the data to at least an additional set of contact data stored in a user database for a match; storing the match within a contact database; extracting a set of user wager market data from the contact database and querying the user database for at least an additional set of user wager market data for a match; informing the user of the match or an absence of a match; displaying a match on a device of the user; and determining if the user is still in the same wager market.

For example, the in a machine learning betting system method, will determine, based upon a user's contacts, if a user contact is matched using machine learning matching of bets in the same market as the user, and informs the user of the contact in the market and the laying bet data of that user. The machine learning matching can match the contacts and types of bets in various ways, for instance the unsupervised machine learning matching may learn of contacts bets in many ways (e.g. that the contacts have bet in the same sequence as the user or is matched where the total profit of a sequence of bets are the same or matched because they are betting against each other).

### EMBODIMENT 68A

### Rolling Plays in a Drive Wager

The present disclosures are generally related to in-play wagering on live sporting events.

The present disclosure provides a method to create new wagers and optimize odds in an online play by play sports betting game by creating odds for the beginning of an offensive possession for what the offensive possession will result in, allowing the user to wager on one or more of the offensive possession results wager odds, then after a play concludes create new wagering odds for the continuation of the offensive possession for the next possible outcomes of the play and allow the user to wager on the new or old wagering odds for what the offensive possession will result in.

### EMBODIMENT 68B

A method to generate wagers and optimize odds on a sport wagering network, comprising: determining at least one set of wagering odds for at least one upcoming event by leveraging historical play data; determining at least a predetermined number of wager odd possibilities for at least a drive wager or a drive result; determining if at least a team is continuing to play offense in an event; determining if at least a set of drive wager odds or a set of drive result odds are available; and sending at least a predetermined number of wager odd possibilities for a least a drive wager or a drive result to a wagering application.

A betting exchange system method to generate wagers and optimize odds on a sport wagering network, comprising: determining at least one set of laying wagering odds for at least one upcoming event by leveraging historical play data; determining at least a predetermined number of laying wager odd possibilities for at least a drive wager or a drive result; determining if at least a team is continuing to play offense in an event; determining if at least a set of drive laying wager odds or a set of drive result odds are available; and sending at least a predetermined number of laying wager odd possibilities for a least a drive wager or a drive result to a wagering application.

For example, the present disclosure provides a betting exchange system method to create new laying wagers and optimize odds in an online play by play sports betting game by creating odds for the beginning of an offensive possession for what the offensive possession will result in, allowing the user to wagers on one or more of the offensive possession results laying wager odds, then after a play concludes create new laying wagering odds for the continuation of the offensive possession for the next possible outcomes of the play and allow the user to wager on the new or old laying wagering odds for what the offensive possession will result in.

A machine learning betting system method to generate wagers and optimize odds on a sport wagering network, comprising: determining at least one set of wagering odds for at least one upcoming event by leveraging historical play data; determining using machine learning at least a predetermined number of wager odd possibilities for at least a drive wager or a drive result; determining if at least a team is continuing to play offense in an event; determining if at least a set of drive wager odds or a set of drive result odds are available; and sending at least a predetermined number of wager odd possibilities for a least a drive wager or a drive result to a wagering application.

For example, the present disclosure provides a in a machine learning betting system method to create new wagers and optimize odds using a supervised machine learning module in an online play by play sports betting game by creating odds for the beginning of an offensive possession for what the offensive possession will result in, allowing the user to wagers on one or more of the offensive possession results wager odds, then after a play concludes create new wagering odds for the continuation of the offensive possession for the next possible outcomes of the play and allow the user to wager on the new or old wagering odds for what the offensive possession will result in. The supervised machine learning is based upon a focus on drive data from the historical data and further learns about the relationship to a first, second, third etc drives as it correlates with the odds given.

### EMBODIMENT 69A

A Method of Providing a User with Betting Statistics

The present disclosures are generally related to play-by-play wagering on live sporting events.

A method of providing usable data to a user of a play-by-play sports wagering network about the user's historical wagering plays similar to a currently open wagering market. For example, the number of times the user has bet on that play type or the user's success rate for that play type. The data could be anonymous. The statistics presented could be the betting statistics of all users or the user's betting statistics.

### EMBODIMENT 69B

A method for providing informational statistical data on a play-by-play sports wagering network, comprising: retrieving wagering market status data from an odds database; identifying users connected to a wagering network; receiving historical wager data from a relationship module; receiving a notification from a trend module and delivering the notification to a mobile device; identifying a cohort of wagers with characteristics similar to a current wagering market; determining if wagers exceed a predetermined similarity threshold by comparing the characteristics of the cohort of wagers to a notification rules database; and identifying a trend in the cohort of historical wagers by comparing statistics of the cohort of historical wagers to statistics of a recent subset of wagers in the cohort.

A betting exchange system method for providing informational statistical data on a play-by-play sports wagering network, comprising: retrieving wagering market status data from an odds database; identifying users connected to a wagering network; receiving historical wager data from a relationship module; receiving a notification from a trend module and delivering the notification to a mobile device; identifying a cohort of laying wagers with characteristics similar to a current laying wagering market; determining if laying wagers exceed a predetermined similarity threshold by comparing the characteristics of the cohort of laying wagers to a notification rules database; and identifying a trend in the cohort of historical wagers by comparing statistics of the cohort of historical wagers to statistics of a recent subset of laying wagers in the cohort.

For example, this invention is a betting exchange system method of providing usable data to a user of a play-by-play sports wagering network about the user's historical laying wagering plays similar to a currently open laying wagering market. For example, the number of times the user has placed a laying bet on that play type or the user's success rate for that play type. The data could be anonymous. The statistics presented could be the betting statistics of all users or the user's betting statistics.

A machine learning betting system method for providing informational statistical data on a play-by-play sports wagering network, comprising: retrieving wagering market status data from an odds database; identifying users connected to a wagering network; receiving historical wager data from a relationship module; receiving a notification from a trend module and delivering the notification to a mobile device; identifying using machine learning a cohort of wagers with characteristics similar to a current wagering market; determining if wagers exceed a predetermined similarity threshold by comparing the characteristics of the cohort of wagers to a notification rules database; and identifying a trend in the cohort of historical wagers by comparing statistics of the cohort of historical wagers to statistics of a recent subset of wagers in the cohort.

For example, this invention is a in a machine learning betting system method of providing usable data to a user of a play-by-play sports wagering network about the user's historical laying wagering plays like a currently open laying wagering market. An unsupervised machine learning system identifies cohorts of wagers with characteristics like a current wagering market. For example, unsupervised machine learning may learn the number of times the user has placed a laying bet on that play type or the user's success rate for that play type. The data could be anonymous. The statistics presented could be the betting statistics of all users or the user's betting statistics.

### EMBODIMENT 70A

Method of Providing a User with Bet-Related Information Prior to Placing a Real-Time Bet

The present disclosures are generally related to play-by-play wagering on live sporting events.

A method of providing usable data to a user of a play-by-play sports wagering network about the factors that may be impacting the odds in a currently open wagering market. Before betting, additional information about circumstances related to the current bet is provided to the user.

### EMBODIMENT 70B

A method for informing a user of characteristics of a live event that impact wager odds on a sports wagering network, comprising: collecting real-time sensor data from the live sporting event; receiving odds that are offered on at least one outcome of a current play in the live event based on the real-time sensor data from a wagering device communicatively coupled to the wagering network; calculating expected odds of the at least one outcome of the current play using historical plays data; determining one or more characteristics of the live event that impact the odds being offered using the real-time sensor data; comparing the offered odds and the expected odds to determine a level of discrepancy between the offered odds and the expected odds; and determining which one or more characteristics of the live event contribute to the level of discrepancy between the offered odds and the expected odds.

A betting exchange system method for informing a user of characteristics of a live event that impact wager odds on a sports wagering network, comprising: collecting real-time sensor data from the live sporting event; receiving odds that are offered on at least one outcome of a current play in the live event based on the real-time sensor data from a wagering device communicatively coupled to the wagering network; calculating expected laying odds of the at least one outcome of the current play using historical plays data; determining one or more characteristics of the live event that impact the odds being offered using the real-time sensor data; comparing the offered laying odds and the expected laying odds to determine a level of discrepancy between the offered laying odds and the expected laying odds; and determining which one or more characteristics of the live event contribute to the level of discrepancy between the laying offered odds and the laying expected odds.

For example, a betting exchange system method provides for a hitter that may have odds for the next hit, based upon evaluating the sheer number of times at bat, but based upon the context, say all bases loaded, the hitter may choose to take the walk to secure a run. The betting exchange will provide laying bets based upon the context of the play.

A machine learning betting system method for informing a user of characteristics of a live event that impact wager odds on a sports wagering network, comprising: collecting real-time sensor data from the live sporting event; receiving odds that are offered on at least one outcome of a current play in the live event based on the real-time sensor data from a wagering device communicatively coupled to the wagering network; calculating using machine learning expected odds of the at least one outcome of the current play using historical plays data; determining one or more characteristics of the live event that impact the odds being offered using the real-time sensor data; comparing the offered odds and the expected odds to determine a level of discrepancy between the offered odds and the expected odds; and determining which one or more characteristics of the live event contribute to the level of discrepancy between the offered odds and the expected odds.

For example, in a machine learning betting system method, provides for a hitter that may have odds calculated using supervised machine learning for the next hit, based upon evaluating the sheer number of times at bat, but based upon the context, say all bases loaded, the hitter may choose to take the walk to secure a run. The betting exchange will provide laying bets based upon the context of the play.

### EMBODIMENT 71A

Method of Managing Wager Micro-Markets with Artificial Intelligence Using Human Traders

The present disclosure is generally related to play-by-play wagering on live sporting events.

The present disclosure provides a method of managing wagering micro-markets using artificial intelligence with human skilled game operators or human traders in which a wagering network contains a historical odds database, as well as a historical database containing the inputs or adjusted odds from skilled game operators, SGOs, that are filtered by the situational data from the live event and correlations, are performed to extract the wagering odds that are correlated allowing the SGO to review the wagering odds and either accept or adjust the wagering odds which are presented to the users through the wagering network.

### EMBODIMENT 71B

A method of having skilled game operators (SGOs) review automatically generated odds comprising; collecting situational data from real time sensors at a live sporting event; filtering an odds database for a first set of odds based on the received situational data; performing correlations on the first set of odds; filtering an SGO database for a second set of odds based on the received situational data; performing correlations on the second set of odds; selecting, if the correlation coefficient of the correlated data from the SGO database exceeds a predetermined threshold, the second set of odds; and selecting, if the correlation coefficient of the correlated data from the SGO database does not exceed a predetermined threshold, the first set of odds.

A betting exchange system method of having skilled game operators (SGOs) review automatically generated laying odds comprising; collecting situational data from real time sensors at a live sporting event; filtering an odds database for a first set of laying odds based on the received situational data; performing correlations on the first set of laying odds; filtering an SGO database for a second set of laying odds based on the received situational data; performing correlations on the second set of odds; selecting, if the correlation coefficient of the correlated data from the SGO database exceeds a predetermined threshold, the second set of laying odds; and selecting, if the correlation coefficient of the correlated data from the SGO database does not exceed a predetermined threshold, the first set of laying odds.

For example, a betting exchange system method uses situational data in a live event (an injury) can change the results of a live event game play. The betting exchange calculates laying odds as usual but monitors situational data. If situational data according to history could change laying odds, this is shown to an SGO. The SGO can then determine which laying odds to offer.

A machine learning betting system method of having skilled game operators (SGOs) review automatically generated odds using machine learning comprising; collecting situational data from real time sensors at a live sporting event; filtering an odds database for a first set of odds based on the received situational data; performing correlations on the first set of odds; filtering an SGO database for a second set of odds based on the received situational data; performing correlations on the second set of odds; selecting, if the correlation coefficient of the correlated data from the SGO database exceeds a predetermined threshold, the second set of odds; and selecting, if the correlation coefficient of the correlated data from the SGO database does not exceed a predetermined threshold, the first set of odds.

For example, in a machine learning betting system method uses situational data in a live event (an injury) can change the results of a live event game play. The machine learning system calculates odds using supervised machine learning as usual but monitors situational data. If situational data according to history could change odds, this is shown to an SGO. The SGO can then determine which odds to offer.

### EMBODIMENT 72A

Method of Managing Wager Micro-Markets with AI Using Human Traders and Weighted Datasets

The present disclosures are generally related to play-by-play wagering on live sporting events.

The present disclosure provides a method of managing wagering micro-markets using artificial intelligence with human skilled game operators or human traders in which a wagering network contains a historical odds database, as well as a historical database that is weighted containing the inputs or adjusted odds from the most profitable skilled game operators, SGOs, that are filtered by the situational data from the live event and correlations, are performed to extract the wagering odds that are correlated allowing the SGO to review the wagering odds and either accept or adjust the wagering odds which are presented to the users through the wagering network.

### EMBODIMENT 72B

A method of managing wagers using skilled game operators (SGOs), comprising: storing odds in an odds database; storing at least situational data and parameters in a skilled game operator (SGO) correction database; storing at least user ID and profit data in an SGO profit database; determining one or more SGOs with a wager success rate over a predetermined threshold; extracting at least one agent ID from the SGO profit database; extracting at least odds data and profit data from the odds database; displaying wagering odds to one or more SGOs and/or a wagering network administrator; prompting the one or more SGOs and/or the wagering network administrator to accept or adjust odds; and storing profit data and odds data in at least the SGO correction database and the SGO profit database.

A betting exchange system method of managing wagers using skilled game operators (SGOs), comprising: storing laying odds in an odds database; storing at least situational data and parameters in a skilled game operator (SGO) correction database; storing at least user ID and profit data in an SGO profit database; determining one or more SGOs with a laying wager success rate over a predetermined threshold; extracting at least one agent ID from the SGO profit database; extracting at least laying odds data and profit data from the odds database; displaying laying wagering odds to one or more SGOs and/or a wagering network administrator; prompting the one or more SGOs and/or the wagering network administrator to accept or adjust laying odds; and storing profit data and laying odds data in at least the SGO correction database and the SGO profit database.

For example, the betting exchange system method can measure the success rate of SGO that provide correction to laying odds before they are displayed to the exchange. The SGO that show a profit over a certain threshold based upon their corrected laying odds are saved in a database for future use, such as weighing which SGO to use on a future laying bets.

A machine learning betting system method of managing wagers using skilled game operators (SGOs), comprising: storing machine learning defined odds in an odds database; storing at least situational data and parameters in a skilled game operator (SGO) correction database; storing at least user ID and profit data in an SGO profit database; determining one or more SGOs with a wager success rate over a predetermined threshold; extracting at least one agent ID from the SGO profit database; extracting at least odds data and profit data from the odds database; displaying wagering odds to one or more SGOs and/or a wagering network administrator; prompting the one or more SGOs and/or the wagering network administrator to accept or adjust odds; and storing profit data and odds data in at least the SGO correction database and the SGO profit database.

For example, the in a machine learning betting system method, can create odds for a bet, using supervised machine learning on any even ply and the machine learning system can measure the success rate of SGO that provide correction to laying odds before they are displayed to the exchange. The SGO that show a profit over a certain threshold based upon their corrected odds are saved in a database for future use, such as weighing which SGO to use on a future bet.

### EMBODIMENT 73A

### Method of Calculating the Odds of a Sports Play Using Data Fidelity

The present embodiments are generally related to play-by-play wagering on live sporting events.

The present disclosure provides a method of calculating the odds of a sports play using data fidelity by using a historical database and extracting the most recent play data and the previous play data, and comparing the extracted play to a set of rules to determine if the data is accurate and should be used to calculate wagering odds or if the data is inaccurate or contains an error which prompts action by the system, such as suspending the current wager market until the data that is received is accurate. Also, the method provides a method of calculating the odds of a sports play using data fidelity by using a historical database and extracting the most recent wager market data or wager odds data and the previous wager market data or wager odd data and compares the data to a set of rules to determine if the data is accurate and if not notifying an administrator of the wagering network or wagering platform of a systematic error or issue.

### EMBODIMENT 73B

A method of ensuring accuracy of calculated odds on a sports wagering network, comprising: initiating a base module; filtering at least one database for live event data; extracting recent and historical play data and/or odds data from at least one database storing at least recent and historical play data and/or odds data; determining differences in recent and historical play and/or odds data through comparison; utilizing differences in the recent and historical play and/or odds data to initiate extraction of at least one play or system rule from a database governing the differences; executing a rule to suspend or disallow wager market activity on a sports wagering network and/or to notify an administrator; storing rules in at least one database; and displaying at least one message to an administrator.

A betting exchange system method of ensuring accuracy of calculated laying odds on a sports wagering network, comprising: initiating a base module; filtering at least one database for live event data; extracting recent and historical play data and/or laying odds data from at least one database storing at least recent and historical play data and/or laying odds data; determining differences in recent and historical play and/or laying odds data through comparison; utilizing differences in the recent and historical play and/or laying odds data to initiate extraction of at least one play or system rule from a database governing the differences; executing a rule to suspend or disallow laying wager market activity on a sports wagering network and/or to notify an administrator; storing rules in at least one database; and displaying at least one message to an administrator.

For example, the betting exchange system method can determine, if a laying odds that is calculated is beyond a threshold, say 10:1, when given to large and success bettors that accept large laying odds. Based upon exceeding the threshold, the laying odds are not offered to the large and successful bettors.

A machine learning betting system method of ensuring accuracy of machine learning calculated odds on a sports wagering network, comprising: initiating a base module; filtering at least one database for live event data; extracting recent and historical play data and/or odds data from at least one database storing at least recent and historical play data and/or odds data; determining differences in recent and historical play and/or odds data through comparison; utilizing differences in the recent and historical play and/or odds data to initiate extraction of at least one play or system rule from a database governing the differences; executing a rule to suspend or disallow wager market activity on a sports wagering network and/or to notify an administrator; storing rules in at least one database; and displaying at least one message to an administrator.

For example, the in a machine learning betting system method can determine, if odds that are calculated using supervised machine learning is beyond a threshold, say 10:1, when given to large and success bettors that accept large odds. Based upon exceeding the threshold, the odds are not offered to the large and successful bettors.

### EMBODIMENT 74A

### Method, System, and Apparatus for Wager Selection

The present disclosures are generally related to play-by-play wagering on live sporting events.

A method of selecting wagers inside a micro-market with on-screen gestures. A user can use a gesture, such as swipe right for a run, swipe left for a pass, or swipe to other bets.

### EMBODIMENT 74B

A method for selecting wagers on a sports betting network, comprising: displaying at least one wagering option on a device; receiving at least one gesture input from the user; determining at least one command stored in a gesture database associated with at least one gesture input; executing at least one associated command; and utilizing haptic feedback to convey that the gesture was received.

A betting exchange system method for selecting laying wagers on a sports betting network, comprising: displaying at least one laying wagering option on a device; receiving at least one gesture input from the user; determining at least one command stored in a gesture database associated with at least one gesture input; executing at least one associated command; and utilizing haptic feedback to convey that the gesture was received.

For example, the betting exchange system method can evaluate a “swipe right” gesture on an icon for accepting a laying bet. Once received the mobile device vibrates.

A machine learning betting system method for selecting wagers machine learning generated wagers on a sports betting network, comprising: displaying at least one wagering option on a device; receiving at least one gesture input from the user; determining at least one command stored in a gesture database associated with at least one gesture input; executing at least one associated command; and utilizing haptic feedback to convey that the gesture was received.

For example, the in a machine learning betting system method, can create wagers and then send to a user mobile device. The machine learning system can evaluate a “swipe right” gesture on an icon for accepting a laying bet. Once received the mobile device vibrates.

### EMBODIMENT 75A

### Method of Using Integrated Sports Wagering System

The present disclosures are generally related to in-play wagering on live sporting events.

The present disclosure provides a method of using an integrated sports wagering system by collecting sensor data available at a sporting event by a server or network located at the sporting event, allowing a user to receive the sensor data by determining the geolocation of the user to be at the sporting event, sending the sensor data to the user to allow the user to use the sensor data as additional information to make more informed wagering decisions.

### EMBODIMENT 75B

A method for using an integrated sports wagering system on a sport wagering network, comprising: connecting to at least one sensor associated with at least one live event; receiving sensor data with a sensor data module from at least one sensor; analyzing and storing the sensor data in a sensor database; extracting and sending sensor data with the sensor data module to an event data module; determining if user geolocation data matches geolocation data for the live event; and displaying the sensor data on a wagering application.

A betting exchange system method for using an integrated sports wagering system to create laying bets to the users of the exchange, comprising: connecting to at least one sensor associated with at least one live event; receiving sensor data with a sensor data module from at least one sensor; analyzing and storing the sensor data in a sensor database; extracting and sending sensor data with the sensor data module to an event data module; determining if user geolocation data matches geolocation data for the live event; and displaying the sensor data on a wagering application.

For example, the present disclosure provides a betting exchange system method for using an integrated sports laying wagering system by collecting sensor data available at a sporting event by a network located at the sporting event, allowing a user to receive the sensor data by determining the geolocation of the user to be at the sporting event, sending the sensor data to the user to allow the user to use the sensor data as additional information to make more informed wagering decisions. When the user is at the physical game, that user may be allowed to see speed of a runner to further determine laying wagers.

A machine learning betting system method for using machine learning generated wagers in an integrated sports wagering system on a sport wagering network, comprising: connecting to at least one sensor associated with at least one live event; receiving sensor data with a sensor data module from at least one sensor; analyzing and storing the sensor data in a sensor database; extracting and sending sensor data with the sensor data module to an event data module; determining if user geolocation data matches geolocation data for the live event; and displaying the sensor data on a wagering application.

For example, the present disclosure provides a in a machine learning betting system method for generating odds using supervised machine learning of an historical database to a current play. The machine learning system uses an integrated sports wagering system by collecting sensor data available at a sporting event by a network located at the sporting event, allowing a user to receive the sensor data by determining the geolocation of the user to be at the sporting event, sending the sensor data to the user to allow the user to use the sensor data as additional information to make more informed wagering decisions. When the user is at the physical game, that user may be allowed to see speed of a runner to further determine wagers.

### EMBODIMENT 76A

Method of Providing Wagering Odds without the Results of A First Play

The embodiments are generally related to play-by-play wagering on live sporting events.

The present disclosure provides a method of determining wagering odds without the results of a first play or previous play by determining the wagering odds for an isolated play by receiving data on the upcoming play, as opposed to the results of the previous play, and determining the wagering odds through a historical database and then comparing the wagering odds from the isolated play to the wagering odds created from a series or sequence of plays and then selecting the more conservative odds to be offered to the users of the wagering network.

### EMBODIMENT 76B

A method of providing wagering odds without the results of the first play on a wagering network, comprising; providing a historical database, and receiving data on an upcoming play or event, and filtering the historical database on the upcoming play, and determining the isolated wagering odds based on the data in the historical database, and receiving the wagering odds created from a series or sequence of plays, and comparing the isolated wagering odds to the wagering odds created from a series or sequence of plays, and selecting the more conservative odds to be offered on a wagering network.

A betting exchange system method of providing laying wagering odds without the results of the first play on a wagering network, comprising; providing a historical database, and receiving data on an upcoming play or event, and filtering the historical database on the upcoming play, and determining the isolated laying wagering odds based on the data in the historical database, and receiving the laying wagering odds created from a series or sequence of plays, and comparing the isolated laying wagering odds to the laying wagering odds created from a series or sequence of plays, and selecting the more conservative laying odds to be offered on a wagering network.

For example, the betting exchange system method would use the historical database and the current play situation, say a particular hitter on the home team to the non-home team pitcher at the 5th inning, to define and create laying odds for an isolated event, such as a “single” for this hitter, as this sequence had more conservative laying odds that say another isolated wager, say a home run.

A machine learning betting system method of providing wagering odds without the results of the first play on a wagering network, comprising; providing a historical database, and receiving data on an upcoming play or event, and filtering, using machine learning, the historical database on the upcoming play, and determining the isolated wagering odds based on the data in the historical database, and receiving the wagering odds created from a series or sequence of plays, and comparing the isolated wagering odds to the wagering odds created from a series or sequence of plays, and selecting the more conservative odds to be offered on a wagering network.

For example, the in a machine learning betting system method would use the historical database and the current play situation, say a particular hitter on the home team to the non-home team pitcher at the 5th inning, to define and create, using supervised machine learning, odds for an isolated event, such as a “single” for this hitter, as this sequence had more conservative odds that say another isolated wager, say a home run.

### EMBODIMENT 77A

### A Method for Celebrating or Taunting Users of a Wagering Network

The present disclosures are generally related to in-play wagering on live sporting events.

The present disclosure provides a method of celebrating or taunting users of a wagering network through sportograms, or sport-related animations or pictures, by allowing a user to subscribe to a sportogram database, allowing a user to connect to various other users of a wagering network, monitoring connected users open wagers to determine if there are related characteristics in a live event to the subscribed sportogram libraries, and allowing a user to send a sportogram to a connected user.

### EMBODIMENT 77B

A method for communicating with users on a sport wagering network, comprising: receiving at least one of subscription request data, sportogram selection data, and connection selection data from a wagering application; retrieving at least subscription data from a sportogram database; retrieving at least connection data from a user database; determining at least one live event characteristic related to an available wager; notifying the wagering application about at least one live event characteristic related to an available wager; and connecting to at least one connection and delivering at least one sportogram selection data.

A betting exchange system method for communicating with users placing laying bets on the betting exchange on a sport wagering network, comprising: receiving at least one of subscription request data, sportogram selection data, and connection selection data from a wagering application; retrieving at least subscription data from a sportogram database; retrieving at least connection data from a user database; determining at least one live event characteristic related to an available wager; notifying the wagering application about at least one live event characteristic related to an available wager; and connecting to at least one connection and delivering at least one sportogram selection data.

For example, the present disclosure provides a betting exchange system method of celebrating or taunting users of a wagering network through sportograms, or sport-related animations or pictures, by allowing a user to subscribe to a sportogram database, allowing a user to connect during a laying bet process to various other users of a wagering network, monitoring connected users open laying wagers to determine if there are related characteristics in a live event to the subscribed sportogram libraries, and allowing a user to send a sportogram to a connected user.

A machine learning betting system method for communicating with users on a sport wagering network using machine learning to create odds and bets, comprising: receiving at least one of subscription request data, sportogram selection data, and connection selection data from a wagering application; retrieving at least subscription data from a sportogram database; retrieving at least connection data from a user database; determining at least one live event characteristic related to an available wager; notifying the wagering application about at least one live event characteristic related to an available wager; and connecting to at least one connection and delivering at least one sportogram selection data.

For example, the present disclosure provides a method using a machine learning betting system method that uses a supervised machine learning module to find bets and calculate odds for an upcoming play of a live event, the method allows for celebrating or taunting users of a wagering network through sportograms, or sport-related animations or pictures, by allowing a user to subscribe to a sportogram database, allowing a user to connect during a laying bet process to various other users of a wagering network, monitoring connected users supervised machine learning calculated open wagers to determine if there are related characteristics in a live event to the subscribed sportogram libraries, and allowing a user to send a sportogram to a connected user.

### EMBODIMENT 78A

### Player Representation Wager Display

The present embodiments are generally related to play-by-play wagering on live sporting events.

A method of informing a user of a sports betting application of his or her performance compared to the user's friends or other users, e.g., this user just fell behind his friend, or this user is doing the best out of his group of friends.

### EMBODIMENT 78B

A method of suggesting wagers to a user based on the contacts of the user in a sports betting network, comprising: receiving contact data from a user on the sports betting network; searching a user database for the received contact data; storing the contact data with an associated data set in a contact database or notifying the user if unable to store the contact data; determining when a new wager data entry has been stored in the user database, extracting a user ID from the wager new data entry; comparing the user ID with contact data in the contact database for a match; and sending a notification to inform the user of the new wager data entry.

A betting exchange system method of suggesting laying wagers to a user based on the contacts of the user in a sports betting network, comprising: receiving contact data from a user on the sports betting network; searching a user database for the received contact data; storing the contact data with an associated data set in a contact database or notifying the user if unable to store the contact data; determining when a new laying wager data entry has been stored in the user database, extracting a user ID from the wager new data entry; comparing the user ID with contact data in the contact database for a match; and sending a notification to inform the user of the new laying wager data entry.

For example, the betting exchange system method allows users to store contacts and when contacts would be notified of a current laying wager, for instance the contact of my brother would be notified on all large laying bets whereas the contact of my best friend who like a given favorite team is sent all laying bets the user makes when betting on the friends favorite team.

A machine learning betting system method of suggesting machine learning defined wagers to a user based on the contacts of the user in a sports betting network, comprising: receiving contact data from a user on the sports betting network; searching a user database for the received contact data; storing the contact data with an associated data set in a contact database or notifying the user if unable to store the contact data; determining when a new wager data entry has been stored in the user database, extracting a user ID from the wager new data entry; comparing the user ID with contact data in the contact database for a match; and sending a notification to inform the user of the new wager data entry.

For example, the machine learning betting system method allows users to store contacts and when contacts would be notified of a current laying wager, for instance the contact of my brother would be notified on all large bets, offered from a supervised learning module. Whereas the contact of my best friend who like a given favorite team is sent all bets, offered from a supervised learning module, the user makes when betting on the friend's favorite team.

### EMBODIMENT 79A

### Method of Storing Wager Data on Server and Communication Device

The present disclosure is generally related to in-play wagering on live sporting events.

A method of storing wager information on both the server and the communication device. Storing a portion of the data locally on the user's device may be able to get around potential bandwidth issues if a user can place wagers on the server when there are no latency issues, but if there are latency issues, the user may place the wager on the communication device and send the placed wager to the server once there are no more latency issues.

### EMBODIMENT 79B

A method for adjusting latency and data transmission on a sports wagering network, comprising: testing a connection from a wagering network to a mobile device using a ping service; measuring a latency level between the wagering network and the mobile device; sending the latency level to a local data level module that receives at least live event data from at least a sensor; comparing the live event data with at least a latency adjustment factor in an adjustment factor database; adjusting the sent latency level by the latency adjustment factor; determining a portion of a wagering process to be stored on the mobile device based on the adjusted latency level; and at least one of instructing the mobile device to store the wagering process portion and halting transmission of that wagering process from the wagering network.

A betting exchange system method for adjusting latency and data transmission on a sports wagering network, comprising: testing a connection from a wagering network to a mobile device using a ping service; measuring a latency level between the wagering network and the mobile device; sending the latency level to a local data level module that receives at least live event data from at least a sensor; comparing the live event data with at least a latency adjustment factor in an adjustment factor database; adjusting the sent latency level by the latency adjustment factor; determining a portion of a laying wagering process to be stored on the mobile device based on the adjusted latency level; and at least one of instructing the mobile device to store the laying wagering process portion and halting transmission of that laying wagering process from the wagering network.

For example, this invention is a betting exchange system method of storing laying wager information on both the network and the communication device. Storing a portion of the data locally on the user's device may be able to get around potential bandwidth issues if a user can place laying wagers on the network when there are no latency issues, but if there are latency issues, the user may place the laying wager on the communication device and send the placed laying wager to the network once there are no more latency issues.

A machine learning betting system method for adjusting latency and data transmission on a sports wagering network, comprising: testing a connection from a wagering network to a mobile device using a ping service; measuring a latency level between the wagering network and the mobile device; sending the latency level to a local data level module that receives at least live event data from at least a sensor; comparing the live event data with at least a latency adjustment factor in an adjustment factor database; adjusting the sent latency level by the latency adjustment factor; determining a portion of a machine learning based wagering process to be stored on the mobile device based on the adjusted latency level; and at least one of instructing the mobile device to store the wagering process portion and halting transmission of that wagering process from the wagering network.

For example, this invention is a machine learning betting system method of storing laying wager information on both the network and the communication device. Storing a portion of the data locally on the user's device may be able to get around potential bandwidth issues if a user can place supervised machine learning based wagers on the network when there are no latency issues, but if there are latency issues, the user may place the supervised machine learning based wager on the communication device and send the placed wager to the network once there are no more latency issues.

### EMBODIMENT 80A

### Latency Display

The embodiments are generally related to in-play wagering on live sporting events.

A method of measuring and representing the latency between the actual events in the live event and the live events as they appear on the user's display.

### EMBODIMENT 80B

A method for representing latency in a connection between a user device and a wagering network providing in-play sports betting, comprising; connecting a user device to an in-play wagering network which offers wagers on a live sporting event; sending, from the in-play wagering network, a ping to the user device; and measuring the latency from the ping sent to the user device.

A betting exchange system method for representing latency in a connection between a user device and a wagering network providing in-play sports betting, comprising; connecting a user device to an in-play wagering network which offers laying wagers on a live sporting event; sending, from the in-play wagering network, a ping to the user device; and measuring the latency from the ping sent to the user device.

For example, the betting exchange system method allows for connecting to a user and offering a laying bet on a sports play event and ping the user to determine the latency. The latency results can be used by the betting exchange to determines when to send another lay bet or to close the market for betting for the specific play.

A machine learning betting system method for representing latency in a connection between a user device and a wagering network providing in-play sports betting, comprising; connecting a user device to an in-play wagering network which offers machine learning wagers on a live sporting event; sending, from the in-play wagering network, a ping to the user device; and measuring the latency from the ping sent to the user device.

For example, the machine learning betting system method allows for connecting to a user and offering a supervised machine learning created bet on a sports play event and also ping the user to determine the latency. The latency results can be used by the machine learning system determines when to send another supervised machine learning created bet or to close the market for betting for the specific play.

### EMBODIMENT 81A

### Authenticate Large Bets

The present embodiments are generally related to play-by-play wagering on live sporting events.

The present disclosure provides a system that allows a user to set threshold preferences for wager limits and the amount of time a wager is placed to allow the user to authenticate or identify themselves when the thresholds are exceeded to reconfirm that the user wishes to place a wager. The system compares the wagers placed by the user to thresholds inputted by the user. If the wager parameters exceed the inputted thresholds, the wagering network reconfirms the wager with the user by requesting a means of authentication to ensure that it is the user placing the wager and determining if the user wants to place the wager and that it was not placed in error.

### EMBODIMENT 81B

A method for authenticating large bets on a sport wagering network, comprising: inputting at least one threshold set by artificial intelligence onto a wagering network; inputting at least one authentication criteria set by artificial intelligence onto a wagering network; storing at least one set threshold in a database; storing at least one set authentication criteria in a database; receiving at least one wager from the user; receiving at least one authentication criteria from the user; determining if the wager of the user exceeds the set threshold; determining the validity of the authentication criteria of the user; and activating a second authentication criteria upon determination that the wager of the user is outside of a predetermined wagering amount or predetermined wagering range.

A betting exchange system method for authenticating large bets on a sport wagering network, comprising: inputting at least one threshold set by artificial intelligence onto a wagering network; inputting at least one authentication criteria set by artificial intelligence onto a wagering network; storing at least one set threshold in a database; storing at least one set authentication criteria in a database; receiving at least one laying wager from the user; receiving at least one authentication criteria from the user; determining if the laying wager of the user exceeds the set threshold; determining the validity of the authentication criteria of the user; and activating a second authentication criteria upon determination that the wager of the user is outside of a predetermined laying wagering amount or predetermined wagering range.

For example, the present disclosure provides a betting exchange system method that allows a user to set threshold preferences for laying wager limits and the amount of time a wager is placed to allow the user to authenticate or identify themselves when the thresholds are exceeded to reconfirm that the user wishes to place a laying wager. The betting exchange system compares the laying wagers placed by the user to thresholds inputted by the user. If the laying wager parameters exceed the inputted thresholds, the wagering network reconfirms the laying wager with the user by requesting a means of authentication to ensure that it is the user placing the laying wager and determining if the user wants to place the wager and that it was not placed in error.

A machine learning betting system method for authenticating large bets on a sport wagering network, comprising: inputting at least one threshold set by artificial intelligence onto a wagering network; inputting at least one authentication criteria set by artificial intelligence onto a wagering network; storing at least one set threshold in a database; storing at least one set authentication criteria in a database; receiving at least one machine learning created wager from the user; receiving at least one authentication criteria from the user; determining if the machine learning created wager of the user exceeds the set threshold; determining the validity of the authentication criteria of the user; and activating a second authentication criteria upon determination that the wager of the user is outside of a predetermined wagering amount or predetermined wagering range.

For example, the present disclosure provides a machine learning betting system method that allows a user to set threshold preferences for supervised machine learning wager limits and the amount of time a wager is placed to allow the user to authenticate or identify themselves when the thresholds are exceeded to reconfirm that the user wishes to place a laying wager. The machine learning system compares the supervised machine learning wagers placed by the user to thresholds inputted by the user. If the supervised machine learning wager parameters exceed the inputted thresholds, the wagering network reconfirms the laying wager with the user by requesting a means of authentication to ensure that it is the user placing the supervised machine learning wager and determining if the user wants to place the wager and that it was not placed in error.

### EMBODIMENT 82A

### Location-Based User Interface

The embodiments are generally related to play-by-play wagering on live sporting events.

The present invention provides a system for updating a wagering application interface to a customized interface with additional functionality based upon the user's physical location, such as a sports arena or stadium, restaurant, or bar. The updated wagering application interface provides the user with a customized appearance that incorporates the home team's colors if located at a stadium or arena or provides signage or advertisements on the interface if the user is located at a sports bar or restaurant. Also, additional functionality can be provided through the wagering application, such as ordering food or providing promotions being offered at the location to allow the user to enjoy a customized wagering experience through the wagering application interface based on the user's physical location.

### EMBODIMENT 82B

A system for enhancing the user experience of an in-play sports betting comprising; providing a Live event; and at least one user mobile device, and a Cloud, and a Wagering Network connected thru Cloud to the users' mobile device, and at least one third-party service provider, and at least one additional device, wherein the wagering network may alter the display on the users' mobile device used to wager on the live event based on the location of the mobile device and allow the user to request services from a third-party service provider and control at least one additional device when inside of a geofence assigned to the third-party service provider.

A betting exchange system for enhancing the user experience of an in-play sports betting comprising; providing a Live event; and at least one user mobile device, and a Cloud, and a Wagering Network connected thru Cloud to the users' mobile device, and at least one third-party service provider, and at least one additional device, wherein the wagering network may alter the display on the users' mobile device used to create laying wagers on the live event based on the location of the mobile device and allow the user to request services from a third-party service provider and control at least one additional device when inside of a geofence assigned to the third-party service provider.

For example, the present invention provides a betting exchange system method for updating a wagering application interface to a customized interface with additional functionality based upon the user's physical location, such as a sports arena or stadium, restaurant, or bar. The updated wagering application allowing users to bet on laying wagers also provides an interface for the user with a customized appearance that incorporates the home team's colors if located at a stadium or arena or provides signage or advertisements on the interface if the user is located at a sports bar or restaurant. Also, additional functionality can be provided through the wagering application, such as ordering food or providing promotions being offered at the location to allow the user to enjoy a customized wagering experience through the wagering application interface based on the user's physical location.

A machine learning betting system method for enhancing the user experience of an in-play sports betting comprising; providing a Live event; and at least one user mobile device, and a Cloud, and a Wagering Network connected thru Cloud to the users' mobile device, and at least one third-party service provider, and at least one additional device, wherein the wagering network may alter the display on the users' mobile device used to create using machine learning wagers on the live event based on the location of the mobile device and allow the user to request services from a third-party service provider and control at least one additional device when inside of a geofence assigned to the third-party service provider.

For example, the present invention provides a machine learning betting system method for updating a wagering application interface to a customized interface with additional functionality based upon the user's physical location, such as a sports arena or stadium, restaurant, or bar. The updated wagering application allowing users to bet on wagers created by supervised machine learning and the machine learning system also provides an interface for the user with a customized appearance that incorporates the home team's colors if located at a stadium or arena or provides signage or advertisements on the interface if the user is located at a sports bar or restaurant. Also, additional functionality can be provided through the wagering application, such as ordering food or providing promotions being offered at the location to allow the user to enjoy a customized wagering experience through the wagering application interface based on the user's physical location.

### EMBODIMENT 83A

### Method of Increasing User Engagement by Offering Incentives to Incrementally Modify User Behavior

The embodiments are generally related to play-by-play wagering on live sporting events.

This invention provides a method of determining appropriate incentives to users of a wagering platform or application by tailoring the incentive to the type of user that they are and provides incentives to increase the user's engagement with the platform or application to modify the user's behavior to allow them to become more experienced users.

### EMBODIMENT 83B

A method of identifying an incentive for a user of a wagering network, comprising; categorizing a user into a user cohort based on user wager history; filtering a user database based on the cohort of the user; offering the user a first incentive based on the user wager history; performing correlations between the first incentive and a desired behavior; and storing a correlation coefficient in a correlation incentive database.

A betting exchange system method of identifying an incentive for a user of a wagering network, comprising; categorizing a user into a user cohort based on user laying wager history; filtering a user database based on the cohort of the user; offering the user a first incentive based on the user laying wager history; performing correlations between the first incentive and a desired behavior; and storing a correlation coefficient in a correlation incentive database.

For example, this invention provides a betting exchange system method of determining appropriate incentives to users of a wagering platform to provide laying wagers to users of the betting exchange and by also providing an application of tailoring the incentive to the type of user that they are and provides incentives to increase the user's engagement with the platform or application to modify the user's behavior to allow them to become more experienced users.

A machine learning betting system method of identifying an incentive for a user of a wagering network, comprising; categorizing a user into a user cohort based on user wager history; filtering a user database based on the cohort of the user; offering using machine learning a user a first incentive based on the user wager history; performing correlations between the first incentive and a desired behavior; and storing a correlation coefficient in a correlation incentive database.

For example, this invention provides a in a machine learning betting system method, of determining appropriate incentives to users of a machine wagering platform or application by tailoring the incentive by using unsupervised machine learning to change and test incentives that work, to offer incentives to the user and the unsupervised machine learning system provides incentives to increase the user's engagement with the platform or application to modify the user's behavior to allow them to become more experienced users.

### EMBODIMENT 84A

### Method of Using Multiple Data Types to Calculate Odds

The present disclosures are generally related to play-by-play wagering on live sporting events.

The present disclosure provides a method for using multiple data types to calculate odds on a wagering network which collects a plurality of data sources from a live event from a game or a match and determines if the data source meets the requirements of the wagering network by comparing the parameters of the data source to the requirements of the wagering network to determine if the data source contains the necessary information to calculate odds for the wagering network.

### EMBODIMENT 84B

A method of utilizing multiple data sources to calculate odds on a wagering network, comprising: collecting at least one data source from at least one sensor in a live event; storing the data source and at least one data parameter in a data source database; offering a data threshold database comprising a list of at least one data threshold requirement; comparing at least one of the data source parameters in the data source database to at least one of the threshold requirements in the data threshold database; determining if the data source meets or exceeds the threshold requirements; and sending the data source to an odds calculation module.

A betting exchange system method of utilizing multiple data sources to calculate laying bets or laying odds on a wagering network, comprising: collecting at least one data source from at least one sensor in a live event; storing the data source and at least one data parameter in a data source database; offering a data threshold database comprising a list of at least one data threshold requirement; comparing at least one of the data source parameters in the data source database to at least one of the threshold requirements in the data threshold database; determining if the data source meets or exceeds the threshold requirements; and sending the data source to an odds calculation module.

For example, the present disclosure provides a betting exchange system method for using multiple data types to calculate laying odds on a wagering network which collects a plurality of data sources, e.g. camera, video feed, audio feed, sensor on a field, sensor on a player, sensor on an official, a data feed, etc. from a live event from a game or a match and determines if the data source meets the requirements of the wagering network by comparing the parameters of the data source to the requirements of the wagering network to determine if the data source contains the necessary information to calculate odds for the wagering network.

A machine learning betting system method of utilizing multiple data sources to use machine learning to calculate odds on a wagering network, comprising: collecting at least one data source from at least one sensor in a live event; storing the data source and at least one data parameter in a data source database; offering a data threshold database comprising a list of at least one data threshold requirement; comparing at least one of the data source parameters in the data source database to at least one of the threshold requirements in the data threshold database; determining if the data source meets or exceeds the threshold requirements; and sending the data source to an odds calculation module.

For example, the present disclosure provides a machine learning betting system method for using multiple data types to calculate odds using supervised machine learning on a wagering network which collects a plurality of data sources, e.g. camera, video feed, audio feed, sensor on a field, sensor on a player, sensor on an official, a data feed, etc. from a live event from a game or a match and determines if the data source meets the requirements of the wagering network by comparing the parameters of the data source to the requirements of the wagering network to determine if the data source contains the necessary information to calculate odds for the wagering network.

### EMBODIMENT 85A

### A Method for a User to Propose a Wager to the House

The embodiments are generally related to play-by-play wagering on live sporting events.

The present disclosure provides a method for a user to propose a wager to the house by allowing the user to input wager criteria for a specific wager market, such as a dollar amount or desired odds, and allowing a wagering network to offer the wager criteria to a plurality of sportsbooks to bid on the wager criteria by sending wager parameters, such as odds for the dollar amount or a maximum dollar amount for the user's desired odds, and allowing the user to select from a plurality of wager parameters and confirming the proposed wager.

### EMBODIMENT 85B

A method for proposing a wager to a sportsbook platform on a wagering network, comprising; allowing a user to input one or more wager parameters on a live event upon which wagers may be placed through a user device in communication with a wagering network; sending the one or more wager parameters to at least one sportsbook platform; receiving a wager offer from each of the at least one sportsbook based on the one or more wager parameters input by the user; and allowing the user to select one of the wager offers received from the at least one sportsbook platform.

A betting exchange system method for proposing a laying wager to a sportsbook platform on a wagering network, comprising; allowing a user to input one or more laying wager parameters on a live event upon which laying wagers may be placed through a user device in communication with a wagering network; sending the one or more laying wager parameters to at least one sportsbook platform; receiving a laying wager offer from each of the at least one sportsbook based on the one or more laying wager parameters input by the user; and allowing the user to select one of the laying wager offers received from the at least one sportsbook platform.

For example, the present disclosure provides a method on a betting exchange system method for a user to propose a laying wager to the house by allowing the user to input laying wager criteria for a specific wager market, such as a dollar amount or desired odds, and allowing a wagering network to offer the laying wager criteria to a plurality of sportsbooks to bid on the laying wager criteria by sending laying wager parameters, such as laying odds for the dollar amount or a maximum dollar amount for the user's desired odds, and allowing the user to select from a plurality of laying wager parameters and confirming the proposed wager.

A machine learning betting system method for proposing a wager calculated by a supervised machine learning module to a sportsbook platform on a wagering network, comprising; allowing a user to input one or more wager parameters on a live event upon which wagers may be placed through a user device in communication with a wagering network; sending the one or more wager parameters to at least one sportsbook platform; receiving a wager offer from each of the at least one sportsbook based on the one or more wager parameters input by the user; and allowing the user to select one of the wager offers received from the at least one sportsbook platform.

For example, the present disclosure provides a machine learning betting system method for a user to propose a wager using a supervised machine learning module to the house by allowing the user to input wager criteria for a specific wager market, such as a dollar amount or desired odds, and allowing a wagering network to offer the wager criteria to a plurality of sportsbooks to bid on the wager criteria by sending wager parameters, such as laying odds for the dollar amount or a maximum dollar amount for the user's desired odds, and allowing the user to select from a plurality of wager parameters and confirming the proposed wager.

### EMBODIMENT 86A

### Geolocation Wager Wins Points Vs Cash

The embodiments are generally related to play-by-play wagering on live sporting events.

A method of disabling cash wagering in a play-by-play sports betting system based on regulations and or user behavior. A user may wager on individual plays inside of a live sporting event. Those wagers may be made for points, or other non-cash equivalents, in jurisdictions in which sports wagering is not allowed or as a means of ensuring responsible gaming.

### EMBODIMENT 86B

A method of disabling cash wagering in a play-by-play sports betting comprising: storing data in a database for wagers of a play-by-play wagering game during a live sporting event, and allowing wagers to be made for cash value or non-cash value, and determining whether wagers may be made for cash value or non-cash value is based on the laws of the jurisdiction, and determining whether wagers may be made for cash value or non-cash value is further based on user behavior, and allowing wagers to be placed on the outcome of a play.

A betting exchange system method of disabling cash lay wagering in a play-by-play sports betting comprising: storing data in a database for wagers of a play-by-play wagering game during a live sporting event, and allowing laying wagers to be made for cash value or non-cash value, and determining whether laying wagers may be made for cash value or non-cash value is based on the laws of the jurisdiction, and determining whether laying wagers may be made for cash value or non-cash value is further based on user behavior, and allowing laying wagers to be placed on the outcome of a play.

For example, a method of using a betting exchange system method whereby disabling cash lay wagering in a play-by-play sports betting system based on regulations and or user behavior. A user may accept lay wagers on individual plays inside of a live sporting event. Those lay wagers may be made for points, or other non-cash equivalents, in jurisdictions in which sports wagering is not allowed or as a means of ensuring responsible gaming.

A machine learning betting system method of disabling cash wagering in a play-by-play sports betting comprising: storing data in a database for wagers of a play-by-play wagering game during a live sporting event, and allowing wagers, calculated by a machine learning module to be made for cash value or non-cash value, and determining whether wagers may be made for cash value or non-cash value is based on the laws of the jurisdiction, and determining whether wagers may be made for cash value or non-cash value is further based on user behavior, and allowing wagers to be placed on the outcome of a play.

For example, a method of using a machine learning betting system method whereby disabling cash wagering in a play-by-play sports betting system based on regulations and or user behavior. A user may accept wagers calculated by supervised machine learning on individual plays inside of a live sporting event. Those wagers may be made for points, or other non-cash equivalents, in jurisdictions in which sports wagering is not allowed or as a means of ensuring responsible gaming.

### EMBODIMENT 87A

### Hedging Assistant

The present disclosures are generally related to in-play wagering on live sporting events.

The present disclosure provides a method to allow the user to hedge their wagers through a hedging assistant that may determine if the user is engaged in a recognizable betting pattern from analyzing the user's wagering history, determining the types of wagers the user has made on the current recognizable betting pattern to determine the user's preferred wager, finding similar wagers that are available in other events, and increasing the odds for the user and allowing the user to wager on the similar wager in another event with increased odds to hedge their current wagers.

### EMBODIMENT 87B

A method for providing wagering options on a sport wagering network, comprising: determining at least one wager pattern within user wagering behavior; determining if the wager pattern is recognizable; extracting and sending user data from a user database to a hedge module; determining at least one preferred wager during the wager pattern; comparing the preferred wager to an odds database and extracting at least one similar wager; and adjusting odds for the similar wager based on a predetermined odds percentage.

A betting exchange system method for providing lay wagering options on a sport wagering network, comprising: determining at least one lay wager pattern within user lay wagering behavior; determining if the lay wager pattern is recognizable; extracting and sending user data from a user database to a hedge module; determining at least one preferred lay wager during the lay wager pattern; comparing the preferred lay wager to an odds database and extracting at least one similar lay wager; and adjusting odds for the similar lay wager based on a predetermined odds percentage.

For example, the present disclosure provides a method using a betting exchange system method to allow the user to hedge their lay wagers through a hedging assistant that may determine if the user is engaged in a recognizable lay betting pattern from analyzing the user's lay wagering history, determining the types of lay wagers the user has made on the current recognizable betting pattern to determine the user's preferred lay wager, finding similar lay wagers that are available in other events, and increasing the laying odds wager for the user and allowing the user to lay wagers on the similar lay wagers in another event with increased laying odds to hedge their current wagers.

A machine learning betting system method for providing wagering options calculated by machine learning on a sport wagering network, comprising: determining at least one wager pattern calculated by machine learning within user wagering behavior; determining if the wager pattern calculated by machine learning is recognizable; extracting and sending user data from a user database to a hedge module; determining at least one preferred wager during the wager pattern; comparing the preferred wager to an odds database and extracting at least one similar wager calculated by machine learning; and adjusting odds for the similar wager based on a predetermined odds percentage.

For example, the present disclosure provides a machine learning betting system method to allow the user to hedge their wagers through a hedging assistant that may determine if the user is engaged in a recognizable betting pattern calculated by supervised machine learning from analyzing the user's lay wagering history, determining the types of wagers calculated by supervised machine learning the user has made on the current recognizable betting pattern to determine the user's preferred wager, finding similar wagers calculated by supervised machine learning that are available in other events, and increasing the odds wager for the user and allowing the user to wagers on the similar wagers in another event with increased odds based upon supervised machine learning to hedge their current wagers.

### EMBODIMENT 88A

### Weighted Statistics

The present disclosures are generally related to play-by-play wagering on live sporting events.

A method of data management through which statistics can be weighed against 3rd party statistics to create normalized statistics that may be used to determine wagering odds for an event, series, or drive in an event or a specific play within an event.

### EMBODIMENT 88B

A method for calculating odds using multiple data sources, comprising: extracting odds data from an odds database and a third-party odds database; connecting to at least one third-party entity and searching at least one third-party database for similar plays to a live event; normalizing extracted odds by either discarding outlier odds through a preset standard deviation or discarding odds as determined by an administrator of a system; calculating odds of the live event by utilizing the normalized odds or pre-calculated odds stored in the third-party database; combining odds data from at least two third parties and the calculated odds by taking a weighted average; and storing the combined odds in the odds database.

A betting exchange system method for calculating laying wager odds using multiple data sources, comprising: extracting laying wager odds data from an odds database and a third-party odds database; connecting to at least one third-party entity and searching at least one third-party database for similar plays to a live event; normalizing extracted laying wager odds by either discarding outlier laying wager odds through a preset standard deviation or discarding laying wager odds as determined by an administrator of a system; calculating laying wager odds of the live event by utilizing the normalized laying wager odds or pre-calculated laying wager odds stored in the third-party database; combining laying wager odds data from at least two third parties and the calculated laying wager odds by taking a weighted average; and storing the combined laying wager odds in the odds database.

For example, a method for betting exchanges system method using data management through which statistics can be weighed against 3rd party statistics to create normalized statistics for laying wagers that may be used to determine lay wagering odds for an event, series, or drive in an event or a specific play within an event.

A machine learning system method for calculating, by machine learning odds using multiple data sources, comprising: extracting odds data by machine learning from an odds database and a third-party odds database; connecting to at least one third-party entity and searching at least one third-party database for similar plays by machine learning to a live event; normalizing extracted odds by either discarding outlier odds through a preset standard deviation or discarding odds as determined by an administrator of a system; calculating odds by machine learning of the live event by utilizing the normalized odds or pre-calculated odds stored in the third-party database; combining odds data from at least two third parties and the calculated odds by taking a weighted average; and storing the combined odds in the odds database.

For example, machine learning betting system method using data management through which statistics can be weighed using supervised machine learning against 3rd party statistics to create normalized statistics for wagers that may be used to determine lay wagering odds for an event, series, or drive in an event or a specific play within an event. The supervised machine learning may evaluate a history of statistics to find results that had a higher probability of wagers wagering.

### EMBODIMENT 89A

### Optimizing the Display Micro-Markets

The present disclosures are generally related to in-play wagering on live sporting events.

A method of displaying and representing available micro-markets to a user in a way that maximizes the number of wagers the user could place.

### EMBODIMENT 89B

A method for optimizing display of wagers options of a sports wagering network, comprising: receiving wager options from an odds database; determining at least one wagering option or a sub-wagering option based on at least one of an option that provides a greatest value to the wagering network, a wagering history of a user, or previous teams that the user has wagered on; utilizing at least one of a learning algorithm or artificial intelligence to ranked selected wagering options for the user; displaying the selected wager through a wagering application; prompting selection of the wagering option or sub-wagering option through one of a pop-up, an application table, an application button, or an application list; and transmitting the selected wagering option or sub-wagering option to the sports wagering network.

A betting exchange system method for optimizing display of lay wagers options of a sports wagering network, comprising: receiving lay wager options from an odds database; determining at least one lay wagering option or a sub-lay-wagering option based on at least one of an option that provides a greatest value to the wagering network, a wagering history of a user, or previous teams that the user has lay wagered on; utilizing at least one of a learning algorithm or artificial intelligence to ranked selected lay wagering options for the user; displaying the selected lay wager through a wagering application; prompting selection of the aly wagering option or sub-lay-wagering option through one of a pop-up, an application table, an application button, or an application list; and transmitting the selected lay wagering option or sub-lay-wagering option to the sports wagering network.

For example, a betting exchange system method of displaying and representing available micro-markets to a user in a way that maximizes the number of lay wagers the user could place.

A machine learning betting system method for optimizing display of wagers options calculated by machine learning of a sports wagering network, comprising: receiving wager options from an odds database; determining at least one wagering option or a sub-wagering option calculated by machine learning based on at least one of an option that provides a greatest value to the wagering network, a wagering history of a user, or previous teams that the user has wagered on; utilizing at least one of a machine learning algorithm or artificial intelligence to ranked selected wagering options for the user; displaying the selected wager through a wagering application; prompting selection of the wagering option or sub-wagering option calculated by machine learning through one of a pop-up, an application table, an application button, or an application list; and transmitting the selected wagering option or sub-wagering option to the sports wagering network.

For example, a machine learning betting system method of displaying and representing available micro-markets to a user in a way that maximizes the number of wagers calculated by supervised machine learning the user could place.

### EMBODIMENT 90A

Method of Verifying that a Wager was Placed Before Market Close

The present disclosures are generally related to play-by-play wagering on live sporting events.

The present disclosure provides a method to determine if a user had placed a wager and verify that the wager was placed before the wagering market closed in a play-by-play wagering network. This method provides the ability to receive a wager from a user and allows the wagering network to receive a timestamp from the user's device to determine if the wager was placed before the market closing. Also, this method provides the ability to verify that there is no fraud, malicious activity, or cheating from the user by verifying that through a 3rd party network, such as the user's network connecting the user to the internet, that the timestamps provided by the network are correct and allowing the user to confirm their wager if received a few moments after the market has closed.

### EMBODIMENT 90B

A method for verifying placement of wagers before a market closes on a sport wagering network, comprising: receiving at least one wager from a which includes a wager timestamp of when the wager was placed; storing the wager timestamp of the wager in a wager time database; verifying the placement of the wager by determining if the wager timestamp of the wager was before the time associated with a close of the wager market; and verifying the validity of the wager timestamp of the wager by connecting to a third-party network, comparing at least one third-party network timestamp with at least one wager timestamp stored in the wager time database, and determining if the at least one third-party network timestamp and at least one wager timestamp are within a predetermined margin of error.

A betting exchange system method for verifying placement of laying wagers before a market closes on a sport wagering network, comprising: receiving at least one laying wager from a which includes a lay wager timestamp of when the lay wager was placed; storing the lay wager timestamp of the lay wager in a wager time database; verifying the placement of the lay wager by determining if the lay wager timestamp of the lay wager was before the time associated with a close of the wager market; and verifying the validity of the lay wager timestamp of the lay wager by connecting to a third-party network, comparing at least one third-party network timestamp with at least one lay wager timestamp stored in the wager time database, and determining if the at least one third-party network timestamp and at least one lay wager timestamp are within a predetermined margin of error.

For example, the present disclosure provides a betting exchange system method to determine if a user had placed a lay wager and verify that the lay wager was placed before the wagering market closed in a play-by-play wagering network. This method provides the ability to receive a lay wager from a user and allows the wagering network to receive a timestamp from the user's device to determine if the lay wager was placed before the market closing. Also, this method provides the ability to verify that there is no fraud, malicious activity, or cheating from the user by verifying that through a 3rd party network, such as the user's network connecting the user to the internet, that the timestamps provided by the network are correct and allowing the user to confirm their lay wager if received a few moments after the market has closed.

A machine learning betting system method for verifying placement of wagers calculated by machine learning before a market closes on a sport wagering network, comprising: receiving at least one wager calculated by machine learning from a which includes a wager timestamp of when the wager was placed; storing the wager timestamp of the wager calculated by machine learning in a wager time database; verifying the placement of the wager calculated by machine learning by determining if the wager timestamp of the wager calculated by machine learning was before the time associated with a close of the wager market; and verifying the validity of the wager timestamp of the wager calculated by machine learning by connecting to a third-party network, comparing at least one third-party network timestamp with at least one wager timestamp stored in the wager time database, and determining if the at least one third-party network timestamp and at least one wager timestamp are within a predetermined margin of error.

For example, the present disclosure provides a machine learning betting system method to determine if a user had placed a wager calculated by supervised machine learning and verify that the wager calculated by supervised machine learning was placed before the wagering market closed in a play-by-play wagering network. This method provides the ability to receive a wager calculated by supervised machine learning from a user and allows the wagering network to receive a timestamp from the user's device to determine if the wager calculated by supervised machine learning was placed before the market closing. Also, this method provides the ability to verify that there is no fraud, malicious activity, or cheating from the user by verifying that through a 3rd party network, such as the user's network connecting the user to the internet, that the timestamps provided by the network are correct and allowing the user to confirm their lay wager if received a few moments after the market has closed.

### EMBODIMENT 91A

### Method for Optimizing Wagering on a Wagering Platform

The present disclosures are generally related to play-by-play wagering on live sporting events.

A method for optimizing wagering on a wagering network by determining the current latency of a mobile device, user device, etc., comparing the current latency to a database that provides the mobile device, user device, etc. with a latency level that is compared to a content database that lists the available content features of the wagering network that are associated with the latency level in order limit the user's issues on the wagering network that are caused by latency issues.

### EMBODIMENT 92A

### Optimizing the Display of Micro-Markets

The present disclosures are generally related to in-play wagering on live sporting events.

A method of icon-based wagering on an in-play sports wagering network. There may be significantly more wagers available at a given time than can be easily displayed on a mobile device. Available wagers are split into top-level wagers and sub-wagers. Top-level wagers are assigned an icon. User selection of a top-level wager icon will open a new screen with related sub-level wagers.

### EMBODIMENT 92B

A method for icon-based wagering within a sport betting network, comprising: searching for at least a top-level wager option and a sub-wager option from a wager relation database; searching for at least one associated icon with the top-level wager option and one associated icon with the sub-wager option in a wager icon database; selecting at least one associated icon with the top-level wager option and one associated icon with the sub-wager option; displaying at least one top-level wager option and one associated icon and at least one sub-wager option and one associated icon via a wagering application; determining selection of at least the top-level wager option and the sub-wager option by receiving an input selection of at least the top-level wager option and the sub-wager option through at least a touch or a click on an associated icon for the top-level wager option and a touch or a click on an associated icon for the sub-wager option; dynamically updating the wagering application to manage a display of at least the top-level wager option and associated icon and the sub-wager option and associated icon; and determining placement of at least one wager and storing at least wager data in a user database.

A betting exchange system method for icon-based lay wagering within a sport betting network, comprising: searching for at least a top-level lay wager option and a sub-lay-wager option from a wager relation database; searching for at least one associated icon with the top-level lay wager option and one associated icon with the sub-lay-wager option in a wager icon database; selecting at least one associated icon with the top-level lay wager option and one associated icon with the sub-lay-wager option; displaying at least one top-level lay wager option and one associated icon and at least one sub-lay-wager option and one associated icon via a wagering application; determining selection of at least the top-level lay wager option and the sub-lay-wager option by receiving an input selection of at least the top-level lay wager option and the sub-lay-wager option through at least a touch or a click on an associated icon for the top-level lay wager option and a touch or a click on an associated icon for the sub-lay-wager option; dynamically updating the wagering application to manage a display of at least the top-level lay wager option and associated icon and the sub-lay-wager option and associated icon; and determining placement of at least one lay wager and storing at least lay wager data in a user database.

For example, a betting exchange system method of icon-based lay wagering on an in-play sports wagering network. There may be significantly more lay wagers available at a given time than can be easily displayed on a mobile device. Available lay wagers are split into top-level lay wagers and sub-lay wagers. Top-level lay wagers are assigned an icon. User selection of a top-level lay wager icon will open a new screen with related sub-lay-level wagers.

A machine learning betting system method for icon-based wagering calculated by machine learning within a sport betting network, comprising: searching for at least a top-level wager option calculated by machine learning and a sub-wager option calculated by machine learning from a wager relation database; searching for at least one associated icon with the top-level wager option calculated by machine learning and one associated icon with the sub-wager option calculated by machine learning in a wager icon database; selecting at least one associated icon with the top-level wager option calculated by machine learning and one associated icon with the sub-wager option calculated by machine learning; displaying at least one top-level wager option calculated by machine learning and one associated icon and at least one sub-wager option calculated by machine learning and one associated icon via a wagering application; determining selection of at least the top-level wager option calculated by machine learning and the sub-wager calculated by machine learning option by receiving an input selection of at least the top-level wager option calculated by machine learning and the sub-wager option calculated by machine learning through at least a touch or a click on an associated icon for the top-level wager option calculated by machine learning and a touch or a click on an associated icon for the sub-wager option calculated by machine learning; dynamically updating the wagering application to manage a display of at least the top-level wager option calculated by machine learning and associated icon and the sub-wager option calculated by machine learning and associated icon; and determining placement of at least one wager and storing at least wager data in a user database.

For example, a machine learning betting system method of icon-based supervised machine learning calculated wagering on an in-play sports wagering network. There may be significantly more supervised machine learning calculated wagers available at a given time than can be easily displayed on a mobile device. Available supervised machine learning calculated wagers are split into supervised machine learning calculated top-level wagers and supervised machine learning calculated sub-wagers. Supervised machine learning calculated top-level wagers are assigned an icon. User selection of supervised machine learning calculated top-level wager icon will open a new screen with related supervised machine learning calculated sub-level wagers.

### EMBODIMENT 93A

Method of Displaying which Users Placed the Same Bet

The present embodiments are generally related to play-by-play wagering on live sporting events.

A method of identifying a wager of interest for a user of a play-by-play sports wagering network and displaying additional information about the amount of wagering activity on either side of a given wagering market when the user's wagering behavior has deviated from their historical behavior.

### EMBODIMENT 93B

A method for outputting targeted proposed wagers on a play-by-play sports wagering network, comprising: storing wagers of a play-by-play wagering game in a database during a live sporting event; allowing placement of wagers on an outcome of a play; identifying a pattern in wagering behavior of a user by searching a database for the wagering history of the user; identifying deviations in the wagering behavior of the user by searching a database for the wagering history of the user; determining an available wager based on an identified pattern in the wagering history of the user or an identified deviation in the wagering history of the user; displaying the available wager to the user; and displaying at least one of current or historical wager statistics to the user, wherein the current or historical wager statistics are related to the available wager.

A betting exchange system method for outputting targeted proposed lay wagers on a play-by-play sports wagering network, comprising: storing lay wagers of a play-by-play wagering game in a database during a live sporting event; allowing placement of lay wagers on an outcome of a play; identifying a pattern in lay wagering behavior of a user by searching a database for the lay wagering history of the user; identifying deviations in the lay wagering behavior of the user by searching a database for the lay wagering history of the user; determining an available lay wager based on an identified pattern in the lay wagering history of the user or an identified deviation in the lay wagering history of the user; displaying the available lay wager to the user; and displaying at least one of current or historical lay wager statistics to the user, wherein the current or historical lay wager statistics are related to the available lay wager.

For example, a betting exchange system method of identifying a lay wager of interest for a user of a play-by-play sports wagering network and displaying additional information about the amount of lay wagering activity on either side of a given wagering market when the user's lay wagering behavior has deviated from their historical behavior.

A machine learning betting system method for outputting targeted proposed wagers calculated by machine learning on a play-by-play sports wagering network, comprising: storing wagers calculated by machine learning of a play-by-play wagering game in a database during a live sporting event; allowing placement of wagers calculated by machine learning on an outcome of a play; identifying a pattern in wagering behavior of a user by searching a database for the wagering history of the user; identifying deviations in the wagering behavior of the user by searching a database for the wagering history of the user; determining an available wager calculated by machine learning based on an identified pattern in the wagering history of the user or an identified deviation in the wagering history of the user; displaying the available wager calculated by machine learning to the user; and displaying at least one of current or historical wager statistics to the user, wherein the current or historical wager statistics are related to the available wager calculated by machine learning.

For example, a machine learning betting system method of identifying a wager, calculated by supervised machine learning, of interest for a user of a play-by-play sports wagering network and displaying additional information about the amount of wagering, calculated by supervised machine learning, activity on either side of a given wagering market when the user's wagering behavior has deviated from their historical behavior.

### EMBODIMENT 94A

Method of Modifying a Wager after Wager Statistics are Displayed

The embodiments are generally related to in-play wagering on live sporting events.

The present disclosure provides a method of modifying a wager after wager statistics are displayed to a user by allowing a user to confirm a wager, determine the wager statistics for the confirmed wager, displaying the wager statistics to the user, and then providing the user an option to modify the wager resulting in the original wager amount to be deducted in which the deduction goes to the house. In addition, the remaining value of the wager is to be placed on the next play or next available wager within the event, and the odds for the next play are decreased, giving the user the chance to win less money but allowing them to modify their previous wager.

### EMBODIMENT 94B

A method of modifying a wager after wager statistics are displayed on an in-play wagering network, comprising; receiving, from a user device, a wager on a play of a live sporting event; determining wager statistics related to the wager received from the user device; displaying the wager statistics on the user device; allowing a user associated with the user device to select to modify the wager; and determining a cost to modify the wager and odds for the modified wager.

A betting exchange system method of modifying a lay wager after lay wager statistics are displayed on an in-play wagering network, comprising; receiving, from a user device, a lay wager on a play of a live sporting event; determining lay wager statistics related to the lay wager received from the user device; displaying the lay wager statistics on the user device; allowing a user associated with the user device to select to modify the lay wager; and determining a cost to modify the lay wager and odds for the modified lay wager.

For example, the present disclosure provides a betting exchange system method of modifying a lay wager after lay wager statistics are displayed to a user by allowing a user to confirm a lay wager, determine the lay wager statistics for the confirmed lay wager, displaying the lay wager statistics to the user, and then providing the user an option to modify the lay wager resulting in the original lay wager amount to be deducted in which the deduction goes to the house. In addition, the remaining value of the lay wager is to be placed on the next play or next available lay wager within the event, and the odds for the next play are decreased, giving the user the chance to win less money but allowing them to modify their previous lay wager.

A machine learning betting system method of modifying a wager calculated by machine learning after wager statistics are displayed on an in-play wagering network, comprising; receiving, from a user device, a wager on a play of a live sporting event; determining wager statistics related to the wager received from the user device; displaying the wager statistics on the user device; allowing a user associated with the user device to select to modify the wager; and determining a cost to modify the wager and odds for the modified wager.

The present disclosure provides a machine learning betting system method of modifying a wager calculated by supervised machine learning after wager statistics are displayed to a user by allowing a user to confirm a wager that was calculated by supervised machine learning, determine the wager statistics for the confirmed wager, displaying the wager statistics to the user, and then providing the user an option to modify the wager resulting in the original wager amount to be deducted in which the deduction goes to the house. In addition, the remaining value of the wager is to be placed on the next play or next available wager within the event, and the odds for the next play are decreased, giving the user the chance to win less money but allowing them to modify their previous wager.

### EMBODIMENT 95A

Method for Artificial Intelligence-Based Changes Based on Deviations from Predictions

The present disclosures are generally related to in-play wagering on live sporting events.

The present disclosure provides a method of artificial intelligence (A.I.) based changes based on deviations from predictions by calculating the wager odds for an upcoming play by play wager, determining the active users on a wagering network, performing correlations between the active user's historical wager data and the wager odds, determining the selected wager and the amount to be wagered for each user, determining the total amount wagered for each side of the wager, determining if there is even action for the wager and if there is not even action updating or altering the wager odds to ensure even action from the users when the wager odds are made available on the wagering network.

### EMBODIMENT 95B

A method for artificial intelligence-based changes driven by deviations from predictions on a sport wagering network, comprising: receiving wager data from an odds database; extracting user data from a user database; determining at least one correlation between received wager data and extracted user data by utilizing at least one of machine learning, artificial intelligence, or determination algorithm; determining if the correlation is above a predetermined correlation threshold; storing user data in a user bet database; determining at least one user wager possibility percentage for at least one possible wager outcome by utilizing at least one of machine learning, artificial intelligence, or determination algorithm; selecting the possible wager outcome with a highest user wager possibility percentage by utilizing at least one of machine learning, artificial intelligence, or determination algorithm; determining if the wager possibility percentage exceeds a predetermined percentage threshold by utilizing at least one of machine learning, artificial intelligence, or determination algorithm; determining at least one average amount wagered and storing the average amount wagered in a user prediction database; determining at least one user who will wager on an outcome and at least an amount to be wagered on the outcome by utilizing at least one of machine learning, artificial intelligence, or determination algorithm; storing the user and the amount to be wagered in a wager prediction database; determining if an even action exists for both sides of a wager and determining an adjustment percentage if the even action does not exist by utilizing at least one of machine learning, artificial intelligence, or determination algorithm; and offering at least wager odds on a wagering application.

A betting exchange system method for artificial intelligence-based changes driven by deviations from predictions on a sport wagering network, comprising: receiving lay wager data from an odds database; extracting user data from a user database; determining at least one correlation between received lay wager data and extracted user data by utilizing at least one of machine learning, artificial intelligence, or determination algorithm; determining if the correlation is above a predetermined correlation threshold; storing user data in a user bet database; determining at least one user lay wager possibility percentage for at least one possible lay wager outcome by utilizing at least one of machine learning, artificial intelligence, or determination algorithm; selecting the possible lay wager outcome with a highest user lay wager possibility percentage by utilizing at least one of machine learning, artificial intelligence, or determination algorithm; determining if the lay wager possibility percentage exceeds a predetermined percentage threshold by utilizing at least one of machine learning, artificial intelligence, or determination algorithm; determining at least one average amount wagered and storing the average amount wagered in a user prediction database; determining at least one user who will lay wager on an outcome and at least an amount to be lay wagered on the outcome by utilizing at least one of machine learning, artificial intelligence, or determination algorithm; storing the user and the amount to be lay wagered in a wager prediction database; determining if an even action exists for both sides of a lay wager and determining an adjustment percentage if the even action does not exist by utilizing at least one of machine learning, artificial intelligence, or determination algorithm; and offering at least lay wager odds on a wagering application.

For example, the present disclosure provides a betting exchange system method of artificial intelligence (A.I.) based changes based on deviations from predictions by calculating the lay wager odds for an upcoming play by play wager, determining the active users on a wagering network, performing correlations between the active user's historical lay wager data and the lay wager odds, determining the selected lay wager and the amount to be lay wagered for each user, determining the total amount wagered for each side of the lay wager, determining if there is even action for the lay wager and if there is not even action updating or altering the lay wager odds to ensure even action from the users when the lay wager odds are made available on the wagering network.

A machine learning betting system method for artificial intelligence-based changes driven by deviations from predictions on a sport wagering network, comprising: receiving wager data from an odds database; extracting user data from a user database; determining at least one correlation between received wager data and extracted user data by utilizing at least one of machine learning, artificial intelligence, or determination algorithm; determining if the correlation is above a predetermined correlation threshold; storing user data in a user bet database; determining at least one user wager possibility percentage for at least one possible wager outcome by utilizing at least one of machine learning, artificial intelligence, or determination algorithm; selecting the possible wager outcome with a highest user wager possibility percentage by utilizing at least one of machine learning, artificial intelligence, or determination algorithm; determining if the wager possibility percentage exceeds a predetermined percentage threshold by utilizing at least one of machine betting learning, artificial intelligence, or determination algorithm; determining at least one average amount wagered and storing the average amount wagered in a user prediction database; determining at least one user who will wager on an outcome and at least an amount to be wagered on the outcome by utilizing at least one of machine learning, artificial intelligence, or determination algorithm; storing the user and the amount to be wagered in a wager prediction database; determining if an even action exists for both sides of a wager and determining an adjustment percentage if the even action does not exist by utilizing at least one of machine learning, artificial intelligence, or determination algorithm; and offering at least wager odds on a wagering application.

For example, the present disclosure provides a machine learning betting system method of artificial intelligence (A.I.) based changes based on deviations from predictions by calculating the wager odds for an upcoming play by play wager, determining the active users on a wagering network, performing correlations between the active user's historical wager data and the wager odds, determining the selected wager and the amount to be wagered for each user, determining the total amount wagered for each side of the wager, determining if there is even action for the wager and if there is not even action updating or altering the wager odds to ensure even action from the users when the wager odds are made available on the wagering network.

### EMBODIMENT 96A

System for Calculating and Storing the Odds Data on a First Wagering Network and Adjusting Odds on a Second Wagering Network Based on the Odds Data from the First Wagering Network.

The present disclosures are generally related to play-by-play wagering on live sporting events.

The present disclosure provides a system for using the odds data from a first wagering network to calculate and adjust wager odds for a second wagering network by receiving the odds data from the first wagering network, such as how many wagers placed, how many users on the wagering market, how much money was wagered and adjusting the odds of an upcoming wager market on a second wagering network depending on the odds data received from the first wagering network.

### EMBODIMENT 96B

A method for calculating and storing the odds data on a first wagering network and adjusting odds on a second wagering network based on the odds data from the first wagering network, comprising: initiating an odds information module to extract and send odds data from an odds database to an odds collection module; connecting the odds collection module to the first wagering network to receive odds data from the odds information module; initiating an odds adjustment module to determine if the received odds data of the first wagering network exceed predetermined thresholds in an odds adjustment database; storing odds data from a first wagering network in at least one odds database; housing at least one threshold to compare odds data with, action to take if the threshold is exceeded or not met, and a data file to run if required by the action in an odds adjustment database; and executing an action to run a data file from the odds adjustment database to alter the odds on the second wagering network.

A betting exchange system method for calculating and storing the lay wager odds data on a first wagering network and adjusting lay wager odds on a second wagering network based on the lay wager odds data from the first wagering network, comprising: initiating an odds information module to extract and send lay wager odds data from an odds database to an odds collection module; connecting the odds collection module to the first wagering network to receive lay wager odds data from the odds information module; initiating an odds adjustment module to determine if the received lay wager odds data of the first wagering network exceed predetermined thresholds in an odds adjustment database; storing lay wager odds data from a first wagering network in at least one odds database; housing at least one threshold to compare lay wager odds data with, action to take if the threshold is exceeded or not met, and a data file to run if required by the action in an lay wager odds adjustment database; and executing an action to run a data file from the odds adjustment database to alter the odds on the second wagering network.

For example, the present disclosure provides a betting exchange system method for using the lay wager odds data from a first wagering network to calculate and adjust lay wager odds for a second wagering network by receiving the lay wager odds data from the first wagering network, such as how many lay wagers placed, how many users on the wagering market, how much money was lay wagered and adjusting the lay wager odds of an upcoming wager market on a second wagering network depending on the lay wager odds data received from the first wagering network.

A machine learning betting system method for calculating using machine learning and storing the machine learning based odds data on a first wagering network and adjusting odds on a second wagering network based on the odds data from the first wagering network, comprising: initiating an odds information module to extract and send odds data from an odds database to an odds collection module; connecting the odds collection module to the first wagering network to receive odds data from the odds information module; initiating an odds adjustment module to determine if the received odds data of the first wagering network exceed predetermined thresholds in an odds adjustment database; storing odds data from a first wagering network in at least one odds database; housing at least one threshold to compare odds data with, action to take if the threshold is exceeded or not met, and a data file to run if required by the action in an odds adjustment database; and executing an action to run a data file from the odds adjustment database to alter the odds on the second wagering network.

For example, the present disclosure provides a machine learning betting system method for using the odds data, calculated by supervised machine learning, from a first wagering network to calculate and adjust wager odds for a second wagering network by receiving the odds data calculated by supervised machine learning, from the first wagering network, such as how many wagers placed, how many users on the wagering market, how much money was wagered and adjusting the odds of an upcoming wager market on a second wagering network depending on the odds data received from the first wagering network.

### EMBODIMENT 97A

### Quantum Sports Betting Algorithms Engine

The present disclosures are generally related to sports betting odds calculations. The odds are calculated on a classical computer or supercomputer, or quantum computed based upon various scenarios of plays and outcomes of plays in “play-by-play” sports betting.

This invention is an engine that allows, for any play in an “in play” or single play betting game, that both calculates “basic odds” (calculated by using historical database mining) and at least one more odds making formula to calculate odds on at least one outcome of a single play in a live event, crossing at least two different odds making formulas to create crossed odds. Then utilizes artificial intelligence to correlate the crossed odds with the final odds on similar historical plays in which odds were calculated. Then, it may use machine learning after the play's outcome is known to correlate the odds generated by each odds making formula with the most profitable odds calculated on previous similar plays. This system may use a hybrid of a basic computer system with AI capability computers and connection to quantum capability computers to assist with calculating odds, specifically where the basic computer can determine when and how much to invoke the AI capability, the Quantum capability, and the combined AI capability, the Quantum capability. The system allows for various quantum capability levels to be used, e.g., 6 Cubit, 50 cubits, 1000 cubit, etc., when determined by the basic computer. The system allows for various parlays to be analyzed using quantum capability. The concept further includes the hybrid computer system to determine when a classical computer, supercomputer, or quantum computer should be used.

### EMBODIMENT 97B

A system for calculating odds on at least one outcome of at least one play in a live sporting event, comprising: at least one processor; and at least one memory having instructions stored thereon which, when executed by the at least one processor, cause the processor to: receive live event data from a live sporting event; determine a probability of available odds in the live event using a probability engine; calculate odds on live event data using at least two odds-making formulas; combine at least two results from the odds-making formulas and determine at least one correlation between the results and historical plays using artificial intelligence; analyze historical play data from a historical plays database for the number of available choices and data and determine to use at least a classical computer within the wagering network, a supercomputer, or a quantum computer to calculate odds on at least one live event; determine a likelihood of the calculated odds providing value to the wagering network through machine learning; and offer the calculated odds on the wagering network.

A betting exchange system for calculating lay odds on at least one outcome of at least one play in a live sporting event, comprising: at least one processor; and at least one memory having instructions stored thereon which, when executed by the at least one processor, cause the processor to: receive live event data from a live sporting event; determine a probability of available lay odds in the live event using a probability engine; calculate lay odds on live event data using at least two lay odds-making formulas; combine at least two results from the lay odds-making formulas and determine at least one correlation between the results and historical plays using artificial intelligence; analyze historical play data from a historical plays database for the number of available choices and data and determine to use at least a classical computer within the wagering network, a supercomputer, or a quantum computer to calculate lay odds on at least one live event; determine a likelihood of the calculated lay odds providing value to the wagering network through machine learning; and offer the calculated lay odds on the wagering network.

For example, this invention is a betting exchange engine system method that allows, for any play in an “in play” or single play betting game, that both calculates “lay basic odds” (calculated by using historical database mining) and at least one more lay odds making formula to calculate lay odds on at least one outcome of a single play in a live event, crossing at least two different lay odds making formulas to create crossed lay odds. Then utilizes artificial intelligence to correlate the crossed lay odds with the final lay odds on similar historical plays in which lay odds were calculated. Then, it may use machine learning after the play's outcome is known to correlate the odds generated by each lay odds making formula with the most profitable lay odds calculated on previous similar plays. This system may usc a hybrid of a basic computer system with AI capability computers and connection to quantum capability computers to assist with calculating lay odds, specifically where the basic computer can determine when and how much to invoke the AI capability, the Quantum capability, and the combined AI capability, the Quantum capability. The system allows for various quantum capability levels to be used, e.g., 6 Cubit, 50 cubits, 1000 cubit, etc., when determined by the basic computer. The system allows for various parlays to be analyzed using quantum capability. The concept further includes the hybrid computer system to determine when a classical computer, supercomputer, or quantum computer should be used.

A machine learning betting system for calculating odds based upon machine learning on at least one outcome of at least one play in a live sporting event, comprising: at least one processor; and at least one memory having instructions stored thereon which, when executed by the at least one processor, cause the processor to: receive live event data from a live sporting event; determine a probability of available odds in the live event using a probability engine; calculate odds on live event data using at least two odds-making formulas; combine at least two results from the odds-making formulas and determine at least one correlation between the results and historical plays using artificial intelligence; analyze historical play data from a historical plays database for the number of available choices and data and determine to use at least a classical computer within the wagering network, a supercomputer, or a quantum computer to calculate odds on at least one live event; determine a likelihood of the calculated odds providing value to the wagering network through machine learning; and offer the calculated odds on the wagering network.

For example, this invention is a machine learning betting system method engine that allows, for any play in an “in play” or single play betting game, that both calculates “basic odds” (calculated by using historical database mining) and at least one more odd making formula to calculate odds on at least one outcome of a single play in a live event, crossing at least two different odds making formulas to create crossed odds. Then utilizes artificial intelligence to correlate the crossed odds with the final odds on similar historical plays in which odds were calculated. Then, it may use supervised machine learning after the play's outcome is known to correlate the odds generated by each odds making formula with the most profitable odds calculated on previous similar plays. This system may use a hybrid of a basic computer system with AI capability computers and connection to quantum capability computers to assist with calculating odds, specifically where the basic computer can determine when and how much to invoke the AI capability, the Quantum capability, and the combined AI capability, the Quantum capability. The system allows for various quantum capability levels to be used, e.g., 6 Cubit, 50 cubits, 1000 cubit, etc., when determined by the basic computer. The system allows for various parlays to be analyzed using quantum capability. The concept further includes the hybrid computer system to determine when a classical computer, supercomputer, or quantum computer should be used.

1-10. (canceled)

11. A method of displaying information on a device of at least one user related to wagering on an action in a live sporting event based on interaction with a live video feed and the at least one user, comprising:
receiving data from a sporting event upon which wagers can be placed on actions occurring during the live sporting event;
providing one more areas for selecting a portion of the video feed of the live sporting event based on one or more of sensor data, character recognition data, facial recognition, artificial intelligence, and/or machine learning; and
displaying, on the device, elements of the sporting event in the selected portion of the video feed of the live sporting event, wherein available data from the sporting event are dependent upon elements of the live sporting event displayed on the device in the selected portion of the video feed of the live sporting event.

12. The method of claim 11, further comprising:
triggering a selection module based on identified elements of the selected portion of the video feed of the sporting event.

13. The method of claim 11, wherein the sensor data comprises physiological data.

14. The method of claim 12, further comprising:
displaying one or more menus based on the selected portion of the video feed of the sporting event.

15. The method of claim 11, further comprising:
displaying historical data related to the identified elements based on the selected portion of the video feed of the sporting event.

16. A system integrating sports wagering into the display of a live sporting event, comprising:
a first device having a first display;
a second device having a second display;
a broadcast of a live sporting event; and
a wagering network,
wherein the wagering network provides one or more wagers on one or more outcomes of actions inside of the live sporting event,
the device controls an integrated display of data associated with the one or more wagers and the broadcast of the live sporting event on the second display,
the data associated with the one or more wagers is displayed on the second display, and
the data associated with the one or more wagers is related to one or more elements of the live sporting event and is overlaid on one or more corresponding elements in the live sporting event, or the data associated with the one or more wagers is displayed at a location on a game play area that is correlated to, or determined by artificial intelligence and/or machine learning, one or more locations relevant to the one or more wagers.

17. The system of claim 16, wherein the first device is communicatively paired to the second device.

18. The system of claim 17, further comprising a display module to display the data associated with the one or more wagers upon a successful pairing of the first device to the second device.

19. The system of claim 16, wherein the data associated with the one or more wagers is displayed in a ribbon on the second device.

20. The system of claim 16, wherein a display module is triggered as a result of an input on the first device.

21. The system of claim 16, wherein inputs on the first device control one or more of the display of the data associated with the one or more wagers on the second device and locations of display of the data associated with the one or more wagers.

22. The system of claim 16, further comprising a wagering module configured to provide wagering activity on the live sporting event in real time.

23. The system of claim 12, wherein the wagering module is coupled to the wagering network and facilitates placing wagers on the mobile device.

24. The system of claim 16, wherein the first device is communicatively paired to a set top box.

25. A method for displaying a probabilistic outcome over video of a live event, comprising:
retrieving at least one active live event upon which probabilistic outcomes can be determined on actions occurring during that live event;
presenting at least one probabilistic outcome on an action occurring during of the live event, the at least one probabilistic outcome determined by artificial intelligence and/or machine learning;
selecting at least one player or object in an area of play inside the live event for providing at least one probabilistic outcome; and
providing at least one a probabilistic outcome on the selection.

26. The method of claim 25, further comprising triggering the presenting of at least one probabilistic outcome on an occurring during of the live event through detection of movement of at least one player inside the live event.

27. The method of claim 25, wherein the at least one player or object who is the basis for the probabilistic outcome is at least one or more players or objects selected from a predetermined group of players or objects.

28. The method of claim 27, wherein the predetermined group of players or objects is based on the type of live event.

29. The method of claim 25, wherein the determination of whether a probabilistic outcome was successful is based on a difference between the actual path taken and the path wager, wherein the path wager is successful if the difference between the actual path taken and the path wager is less than a threshold value.
